(19) United States
(12) Patent Application Publication
(10) Pub. No.: US 2013/0024408 A1
(43) Pub. Date: Jan. 24, 2013

(54) ACTION EXECUTION BASED ON USER MODIFIED HYPOTHESIS

(71) Applicants: Shawn P. Firminger, Redmond, WA (US); Jason Garms, Redmond, WA (US); Edward K.Y. Jung, Bellevue, WA (US); Chris D. Karkanias, Sammamish, WA (US); Eric C. Leuthardt, St. Louis, MO (US); Royce A. Levien, Lexington, MA (US); Robert W. Lord, Seattle, WA (US); Mark A. Malamud, Seattle, WA (US); John D. Rinaldo, JR., Bellevue, WA (US); Clarence T. Tegreene, Bellevue, WA (US); Kristin M. Tolle, Redmond, WA (US); Lowell L. Wood, JR., Bellevue, WA (US)

(72) Inventors: Shawn P. Firminger, Redmond, WA (US); Jason Garms, Redmond, WA (US); Edward K.Y. Jung, Bellevue, WA (US); Chris D. Karkanias, Sammamish, WA (US); Eric C. Leuthardt, St. Louis, MO (US); Royce A. Levien, Lexington, MA (US); Robert W. Lord, Seattle, WA (US); Mark A. Malamud, Seattle, WA (US); John D. Rinaldo, JR., Bellevue, WA (US); Clarence T. Tegreene, Bellevue, WA (US); Kristin M. Tolle, Redmond, WA (US); Lowell L. Wood, JR., Bellevue, WA (US)

(73) Assignee: Searete LLC, a limited liability corporation of the State of Delaware

(21) Appl. No.: 13/545,257

(22) Filed: Jul. 10, 2012

Related U.S. Application Data
(63) Continuation-in-part of application No. 12/462,128, filed on Jul. 28, 2009, now Pat. No. 8,180,830.
Application No. 12/462,128 is a continuation of application No. 12/462,201, filed on Jul. 29, 2009, now Pat. No. 8,244,858.
Application No. 12/462,201 is a continuation-in-part of application No. 12/313,659, filed on Nov. 21, 2008, now Pat. No. 8,046,455.
Application No. 12/313,659 is a continuation-in-part of application No. 12/315,083, filed on Nov. 26, 2008, now Pat. No. 8,005,948.
Application No. 12/315,083 is a continuation-in-part of application No. 12/319,135, filed on Dec. 31, 2008, now Pat. No. 7,937,465.
Application No. 12/319,135 is a continuation-in-part of application No. 12/378,162, filed on Feb. 9, 2009, now Pat. No. 8,028,063.
Application No. 12/378,162 is a continuation-in-part of application No. 12/319,134, filed on Dec. 31, 2008, now Pat. No. 7,945,632.
Application No. 12/319,134 is a continuation-in-part of application No. 12/378,288, filed on Feb. 11, 2009, now Pat. No. 8,032,628.
Application No. 12/378,288 is a continuation-in-part of application No. 12/380,409, filed on Feb. 25, 2009, now Pat. No. 8,010,662.
Application No. 12/380,409 is a continuation-in-part of application No. 12/380,573, filed on Feb. 26, 2009, now Pat. No. 8,260,729.
Application No. 12/380,573 is a continuation-in-part of application No. 12/383,581, filed on Mar. 24, 2009, now abandoned.
Application No. 12/383,581 is a continuation-in-part of application No. 12/383,817, filed on Mar. 25, 2009, now Pat. No. 8,010,663.
Application No. 12/383,817 is a continuation-in-part of application No. 12/384,660, filed on Apr. 6, 2009, now Pat. No. 8,180,890.
Application No. 12/384,660 is a continuation-in-part of application No. 12/384,779, filed on Apr. 7, 2009, now Pat. No. 8,260,912.
Application No. 12/384,779 is a continuation-in-part of application No. 12/387,487, filed on Apr. 30, 2009, now Pat. No. 8,086,668.
Application No. 12/387,487 is a continuation-in-part of application No. 12/387,465, filed on Apr. 30, 2009, now Pat. No. 8,103,613.
Application No. 12/387,465 is a continuation-in-part of application No. 12/455,309, filed on May 28, 2009, now Pat. No. 8,010,664.
Application No. 12/455,309 is a continuation-in-part of application No. 12/455,317, filed on May 29, 2009, now abandoned.
Application No. 12/455,317 is a continuation-in-part of application No. 12/456,249, filed on Jun. 12, 2009, now Pat. No. 8,224,956.
Application No. 12/456,249 is a continuation-in-part of application No. 12/456,433, filed on Jun. 15, 2009, now Pat. No. 8,224,842.
Application No. 12/456,433 is a continuation-in-part of application No. 12/459,775, filed on Jul. 6, 2009, now Pat. No. 8,127,002.
Application No. 12/459,775 is a continuation-in-part of application No. 12/459,854, filed on Jul. 7, 2009, now Pat. No. 8,239,488.

(51) Int. Cl. G06F 15/18

(52) U.S. Cl. 706/17

(57) ABSTRACT

A computationally implemented method includes, but is not limited to: selecting at least one hypothesis from a plurality of hypotheses relevant to a user, the selection of the at least one hypothesis being based, at least in part, on at least one reported event associated with the user; and presenting one or more advisories related to the hypothesis. In addition to the foregoing, other method aspects are described in the claims, drawings, and text forming a part of the present disclosure.

### CROSS-REFERENCE TO RELATED APPLICATIONS

The present application is related to and claims the benefit of the earliest available effective filing date(s) from the following listed application(s) (the “Related Applications”) (e.g., claims earliest available priority dates for other than provisional patent applications or claims benefits under 35 USC §119(e) for provisional patent applications, for any and all parent, grandparent, great-grandparent, etc. applications of the Related Application(s)). All subject matter of the Related Applications and of any and all parent, grandparent, great-grandparent, etc. applications of the Related Applications is incorporated herein by reference to the extent such subject matter is not inconsistent herewith.

### RELATED APPLICATIONS

For purposes of the USPTO extra-statutory requirements, the present application constitutes a continuation-in-part of U.S. patent application Ser. No. 12/462,128, entitled ACTION EXECUTION BASED ON USER MODIFIED HYPOTHESIS, naming Shawn P. Firminger; Jason Garms; Edward K. Y. Jung; Chris D. Karkanias; Eric C. Leuthardt; Royce A. Levien; Robert W. Lord; Mark A. Malamud; John D. Rinaldo, Jr.; Clarence T. Tegreene; Kristin M. Tolle; Lowell L. Wood, Jr. as inventors, filed 28 Jul. 2009, which is currently co-pending or is an application of which a currently co-pending application is entitled to the benefit of the filing date.

For purposes of the USPTO extra-statutory requirements, the present application constitutes a continuation of U.S. patent application Ser. No. 12/462,201, entitled ACTION EXECUTION BASED ON USER MODIFIED HYPOTHESIS, naming Shawn P. Firminger; Jason Garms; Edward K. Y. Jung; Chris D. Karkanias; Eric C. Leuthardt; Royce A. Levien; Robert W. Lord; Mark A. Malamud; John D. Rinaldo, Jr.; Clarence T. Tegreene; Kristin M. Tolle; Lowell L. Wood, Jr. as inventors, filed 29 Jul. 2009, which is currently co-pending or is an application of which a currently co-pending application is entitled to the benefit of the filing date.

For purposes of the USPTO extra-statutory requirements, the present application constitutes a continuation-in-part of U.S. patent application Ser. No. 12/313,659, entitled CORRELATING SUBJECTIVE USER STATES WITH OBJECTIVE OCCURRENCES ASSOCIATED WITH A USER, naming Shawn P. Firminger, Jason Garms, Edward K. Y. Jung, Chris D. Karkanias, Eric C. Leuthardt, Royce A. Levien, Robert W. Lord, Mark A. Malamud, John D. Rinaldo, Jr., Clarence T. Tegreene, Kristin M. Tolle, and Lowell L. Wood, Jr., as inventors, filed 21 Nov. 2008, which is currently co-pending, or is an application of which a currently co-pending application is entitled to the benefit of the filing date.

For purposes of the USPTO extra-statutory requirements, the present application constitutes a continuation-in-part of U.S. patent application Ser. No. 12/315,083, entitled CORRELATING SUBJECTIVE USER STATES WITH OBJECTIVE OCCURRENCES ASSOCIATED WITH A USER, naming Shawn P. Firminger, Jason Garms, Edward K. Y. Jung, Chris D. Karkanias, Eric C. Leuthardt, Royce A. Levien, Robert W. Lord, Mark A. Malamud, John D. Rinaldo, Jr., Clarence T. Tegreene, Kristin M. Tolle, and Lowell L. Wood, Jr., as inventors, filed 26 Nov. 2008, which is currently co-pending, or is an application of which a currently co-pending application is entitled to the benefit of the filing date.

For purposes of the USPTO extra-statutory requirements, the present application constitutes a continuation-in-part of U.S. patent application Ser. No. 12/319,135, entitled CORRELATING DATA INDICATING AT LEAST ONE SUBJECTIVE USER STATE WITH DATA INDICATING AT LEAST ONE OBJECTIVE OCCURRENCE ASSOCIATED WITH A USER, naming Shawn P. Firminger; Jason Garms; Edward K. Y. Jung; Chris D. Karkanias; Eric C. Leuthardt; Royce A. Levien; Robert W. Lord; Mark A. Malamud; John D. Rinaldo, Jr.; Clarence T. Tegreene; Kristin M. Tolle; Lowell L. Wood, Jr. as inventors, filed 31 Dec. 2008, which is currently co-pending, or is an application of which a currently co-pending application is entitled to the benefit of the filing date.

For purposes of the USPTO extra-statutory requirements, the present application constitutes a continuation-in-part of U.S. patent application Ser. No. 12/319,134, entitled CORRELATING DATA INDICATING AT LEAST ONE SUBJECTIVE USER STATE WITH DATA INDICATING AT LEAST ONE OBJECTIVE OCCURRENCE ASSOCIATED WITH A USER, naming Shawn P. Firminger; Jason Garms; Edward K. Y. Jung; Chris D. Karkanias; Eric C. Leuthardt; Royce A. Levien; Robert W. Lord; Mark A. Malamud; John D. Rinaldo, Jr.; Clarence T. Tegreene; Kristin M. Tolle; Lowell L. Wood, Jr. as inventors, filed 31 Dec. 2008, which is currently co-pending, or is an application of which a currently co-pending application is entitled to the benefit of the filing date.

For purposes of the USPTO extra-statutory requirements, the present application constitutes a continuation-in-part of U.S. patent application Ser. No. 12/378,162, entitled SOLICITING DATA INDICATING AT LEAST ONE OBJECTIVE OCCURRENCE IN RESPONSE TO ACQUISITION OF DATA INDICATING AT LEAST ONE SUBJECTIVE USER STATE, naming Shawn P. Firminger; Jason Garms; Edward K. Y. Jung; Chris D. Karkanias; Eric C. Leuthardt; Royce A. Levien; Robert W. Lord; Mark A. Malamud; John D. Rinaldo, Jr.; Clarence T. Tegreene; Kristin M. Tolle; Lowell L. Wood, Jr. as inventors, filed 9 Feb. 2009, which is currently co-pending, or is an application of which a currently co-pending application is entitled to the benefit of the filing date.

For purposes of the USPTO extra-statutory requirements, the present application constitutes a continuation-in-part of U.S. patent application Ser. No. 12/378,288, entitled SOLICITING DATA INDICATING AT LEAST ONE OBJECTIVE OCCURRENCE IN RESPONSE TO ACQUISITION OF DATA INDICATING AT LEAST ONE SUBJECTIVE USER STATE, naming Shawn P. Firminger; Jason Garms; Edward K. Y. Jung; Chris D. Karkanias; Eric C. Leuthardt; Royce A. Levien; Robert W. Lord; Mark A. Malamud; John D. Rinaldo, Jr.; Clarence T. Tegreene; Kristin M. Tolle; Lowell L. Wood, Jr. as inventors, filed 11 Feb. 2009, which is currently co-pending, or is an application of which a currently co-pending application is entitled to the benefit of the filing date.

For purposes of the USPTO extra-statutory requirements, the present application constitutes a continuation-in-part of U.S. patent application Ser. No. 12/380,409, entitled SOLICITING DATA INDICATING AT LEAST ONE SUBJECTIVE USER STATE IN RESPONSE TO ACQUISITION OF DATA INDICATING AT LEAST ONE OBJECTIVE OCCURRENCE, naming Shawn P. Firminger; Jason Garms; Edward K. Y. Jung; Chris D. Karkanias; Eric C. Leuthardt; Royce A. Levien; Robert W. Lord; Mark A. Malamud; John D. Rinaldo, Jr.; Clarence T. Tegreene; Kristin M. Tolle; Lowell L. Wood, Jr. as inventors, filed 25 Feb. 2009, which is currently co-pending, or is an application of which a currently co-pending application is entitled to the benefit of the filing date.

For purposes of the USPTO extra-statutory requirements, the present application constitutes a continuation-in-part of U.S. patent application Ser. No. 12/380,573, entitled SOLICITING DATA INDICATING AT LEAST ONE SUBJECTIVE USER STATE IN RESPONSE TO ACQUISITION OF DATA INDICATING AT LEAST ONE OBJECTIVE OCCURRENCE, naming Shawn P. Firminger; Jason Garms; Edward K. Y. Jung; Chris D. Karkanias; Eric C. Leuthardt; Royce A. Levien; Robert W. Lord; Mark A. Malamud; John D. Rinaldo, Jr.; Clarence T. Tegreene; Kristin M. Tolle; Lowell L. Wood, Jr. as inventors, filed 26 Feb. 2009, which is currently co-pending, or is an application of which a currently co-pending application is entitled to the benefit of the filing date.

For purposes of the USPTO extra-statutory requirements, the present application constitutes a continuation-in-part of U.S. patent application Ser. No. 12/383,581, entitled CORRELATING DATA INDICATING SUBJECTIVE USER STATES ASSOCIATED WITH MULTIPLE USERS WITH DATA INDICATING OBJECTIVE OCCURRENCES, naming Shawn P. Firminger, Jason Garms, Edward K. Y. Jung, Chris D. Karkanias, Eric C. Leuthardt, Royce A. Levien, Robert W. Lord, Mark A. Malamud, John D. Rinaldo, Jr., Clarence T. Tegreene, Kristin M. Tolle, and Lowell L. Wood, Jr., as inventors, filed 24 Mar. 2009, which is currently co-pending, or is an application of which a currently co-pending application is entitled to the benefit of the filing date.

For purposes of the USPTO extra-statutory requirements, the present application constitutes a continuation-in-part of U.S. patent application Ser. No. 12/383,817, entitled CORRELATING DATA INDICATING SUBJECTIVE USER STATES ASSOCIATED WITH MULTIPLE USERS WITH DATA INDICATING OBJECTIVE OCCURRENCES, naming Shawn P. Firminger, Jason Garms, Edward K. Y. Jung, Chris D. Karkanias, Eric C. Leuthardt, Royce A. Levien, Robert W. Lord, Mark A. Malamud, John D. Rinaldo, Jr., Clarence T. Tegreene, Kristin M. Tolle, and Lowell L. Wood, Jr., as inventors, filed 25 Mar. 2009, which is currently co-pending, or is an application of which a currently co-pending application is entitled to the benefit of the filing date.

For purposes of the USPTO extra-statutory requirements, the present application constitutes a continuation-in-part of U.S. patent application Ser. No. 12/384,660, entitled HYPOTHESIS BASED SOLICITATION OF DATA INDICATING AT LEAST ONE SUBJECTIVE USER STATE, naming Shawn P. Firminger, Jason Garms, Edward K. Y. Jung, Chris D. Karkanias, Eric C. Leuthardt, Royce A. Levien, Robert W. Lord, Mark A. Malamud, John D. Rinaldo, Jr., Clarence T. Tegreene, Kristin M. Tolle, and Lowell L. Wood, Jr., as inventors, filed 6 Apr. 2009, which is currently co-pending, or is an application of which a currently co-pending application is entitled to the benefit of the filing date.

For purposes of the USPTO extra-statutory requirements, the present application constitutes a continuation-in-part of U.S. patent application Ser. No. 12/384,779, entitled HYPOTHESIS BASED SOLICITATION OF DATA INDICATING AT LEAST ONE SUBJECTIVE USER STATE, naming Shawn P. Firminger, Jason Garms, Edward K. Y. Jung, Chris D. Karkanias, Eric C. Leuthardt, Royce A. Levien, Robert W. Lord, Mark A. Malamud, John D. Rinaldo, Jr., Clarence T. Tegreene, Kristin M. Tolle, and Lowell L. Wood, Jr., as inventors, filed 7 Apr. 2009, which is currently co-pending, or is an application of which a currently co-pending application is entitled to the benefit of the filing date.

For purposes of the USPTO extra-statutory requirements, the present application constitutes a continuation-in-part of U.S. patent application Ser. No. 12/387,487, entitled HYPOTHESIS BASED SOLICITATION OF DATA INDICATING AT LEAST ONE OBJECTIVE OCCURRENCE, naming Shawn P. Firminger, Jason Garms, Edward K. Y. Jung, Chris D. Karkanias, Eric C. Leuthardt, Royce A. Levien, Robert W. Lord, Mark A. Malamud, John D. Rinaldo, Jr., Clarence T. Tegreene, Kristin M. Tolle, and Lowell L. Wood, Jr., as inventors, filed 30 Apr. 2009, which is currently co-pending, or is an application of which a currently co-pending application is entitled to the benefit of the filing date.

For purposes of the USPTO extra-statutory requirements, the present application constitutes a continuation-in-part of U.S. patent application Ser. No. 12/387,465, entitled HYPOTHESIS BASED SOLICITATION OF DATA INDICATING AT LEAST ONE OBJECTIVE OCCURRENCE, naming Shawn P. Firminger, Jason Garms, Edward K. Y. Jung, Chris D. Karkanias, Eric C. Leuthardt, Royce A. Levien, Robert W. Lord, Mark A. Malamud, John D. Rinaldo, Jr., Clarence T. Tegreene, Kristin M. Tolle, and Lowell L. Wood, Jr., as inventors, filed 30 Apr. 2009, which is currently co-pending, or is an application of which a currently co-pending application is entitled to the benefit of the filing date.

For purposes of the USPTO extra-statutory requirements, the present application constitutes a continuation-in-part of U.S. patent application Ser. No. 12/455,309, entitled HYPOTHESIS DEVELOPMENT BASED ON SELECTIVE REPORTED EVENTS, naming Shawn P. Firminger, Jason Garms, Edward K. Y. Jung, Chris D. Karkanias, Eric C. Leuthardt, Royce A. Levien, Robert W. Lord, Mark A. Malamud, John D. Rinaldo, Jr., Clarence T. Tegreene, Kristin M. Tolle, and Lowell L. Wood, Jr., as inventors, filed 28 May 2009, which is currently co-pending, or is an application of which a currently co-pending application is entitled to the benefit of the filing date.

For purposes of the USPTO extra-statutory requirements, the present application constitutes a continuation-in-part of U.S. patent application Ser. No. 12/455,317, entitled HYPOTHESIS DEVELOPMENT BASED ON SELECTIVE REPORTED EVENTS, naming Shawn P. Firminger, Jason Garms, Edward K. Y. Jung, Chris D. Karkanias, Eric C. Leuthardt, Royce A. Levien, Robert W. Lord, Mark A. Malamud, John D. Rinaldo, Jr., Clarence T. Tegreene, Kristin M. Tolle, and Lowell L. Wood, Jr., as inventors, filed 29 May 2009, which is currently co-pending, or is an application of which a currently co-pending application is entitled to the benefit of the filing date.

For purposes of the USPTO extra-statutory requirements, the present application constitutes a continuation-in-part of U.S. patent application Ser. No. 12/456,249, entitled HYPOTHESIS SELECTION AND PRESENTATION OF ONE OR MORE ADVISORIES, naming Shawn P. Firminger, Jason Garms, Edward K. Y. Jung, Chris D. Karkanias, Eric C. Leuthardt, Royce A. Levien, Robert W. Lord, Mark A. Malamud, John D. Rinaldo, Jr., Clarence T. Tegreene, Kristin M. Tolle, and Lowell L. Wood, Jr., as inventors, filed 12 Jun. 2009, which is currently co-pending, or is an application of which a currently co-pending application is entitled to the benefit of the filing date.

For purposes of the USPTO extra-statutory requirements, the present application constitutes a continuation-in-part of U.S. patent application Ser. No. 12/456,433, entitled HYPOTHESIS SELECTION AND PRESENTATION OF ONE OR MORE ADVISORIES, naming Shawn P. Firminger, Jason Garms, Edward K. Y. Jung, Chris D. Karkanias, Eric C. Leuthardt, Royce A. Levien, Robert W. Lord, Mark A. Malamud, John D. Rinaldo, Jr., Clarence T. Tegreene, Kristin M. Tolle, and Lowell L. Wood, Jr., as inventors, filed 15 Jun. 2009, which is currently co-pending, or is an application of which a currently co-pending application is entitled to the benefit of the filing date.

For purposes of the USPTO extra-statutory requirements, the present application constitutes a continuation-in-part of U.S. patent application Ser. No. 12/459,775, entitled HYPOTHESIS DEVELOPMENT BASED ON USER AND SENSING DEVICE DATA, naming Shawn P. Firminger, Jason Garms, Edward K. Y. Jung, Chris D. Karkanias, Eric C. Leuthardt, Royce A. Levien, Robert W. Lord, Mark A. Malamud, John D. Rinaldo, Jr., Clarence T. Tegreene, Kristin M. Tolle, and Lowell L. Wood, Jr., as inventors, filed 6 Jul. 2009, which is currently co-pending, or is an application of which a currently co-pending application is entitled to the benefit of the filing date.

For purposes of the USPTO extra-statutory requirements, the present application constitutes a continuation-in-part of U.S. patent application Ser. No. 12/459,854, entitled HYPOTHESIS DEVELOPMENT BASED ON USER AND SENSING DEVICE DATA, naming Shawn P. Firminger, Jason Garms, Edward K. Y. Jung, Chris D. Karkanias, Eric C. Leuthardt, Royce A. Levien, Robert W. Lord, Mark A. Malamud, John D. Rinaldo, Jr., Clarence T. Tegreene, Kristin M. Tolle, and Lowell L. Wood, Jr., as inventors, filed 7 Jul. 2009, which is currently co-pending, or is an application of which a currently co-pending application is entitled to the benefit of the filing date.

The United States Patent Office (USPTO) has published a notice to the effect that the USPTO's computer programs require that patent applicants reference both a serial number and indicate whether an application is a continuation or continuation-in-part. Stephen G. Kunin, Benefit of Prior-Filed Application, USPTO Official Gazette Mar. 18, 2003, available at http://www.uspto.gov/web/offices/com/sol/og/2003/week11/patbene.htm. The present Applicant Entity (hereinafter “Applicant”) has provided above a specific reference to the application(s) from which priority is being claimed as recited by statute. Applicant understands that the statute is unambiguous in its specific reference language and does not require either a serial number or any characterization, such as “continuation” or “continuation-in-part,” for claiming priority to U.S. patent applications. Notwithstanding the foregoing, Applicant understands that the USPTO's computer programs have certain data entry requirements, and hence Applicant is designating the present application as a continuation-in-part of its parent applications as set forth above, but expressly points out that such designations are not to be construed in any way as any type of commentary and/or admission as to whether or not the present application contains any new matter in addition to the matter of its parent application(s).

All subject matter of the Related Applications and of any and all parent, grandparent, great-grandparent, etc. applications of the Related Applications is incorporated herein by reference to the extent such subject matter is not inconsistent herewith.

### SUMMARY

A computationally implemented method includes, but is not limited to presenting to a user a hypothesis identifying at least a relationship between a first event type and a second event type; receiving from the user one or more modifications to modify the hypothesis; and executing one or more actions based, at least in part, on a modified hypothesis resulting, at least in part, from the reception of the one or more modifications. In addition to the foregoing, other method aspects are described in the claims, drawings, and text forming a part of the present disclosure.

In one or more various aspects, related systems include but are not limited to circuitry and/or programming for effecting the herein-referenced method aspects; the circuitry and/or programming can be virtually any combination of hardware, software, and/or firmware configured to effect the herein-referenced method aspects depending upon the design choices of the system designer.

A computationally implemented system includes, but is not limited to: means for presenting to a user a hypothesis identifying at least a relationship between a first event type and a second event type; means for receiving from the user one or more modifications to modify the hypothesis; and means for executing one or more actions based, at least in part, on a modified hypothesis resulting, at least in part, from the reception of the one or more modifications. In addition to the foregoing, other system aspects are described in the claims, drawings, and text forming a part of the present disclosure.

A computationally implemented system includes, but is not limited to: circuitry for presenting to a user a hypothesis identifying at least a relationship between a first event type and a second event type; circuitry for receiving from the user one or more modifications to modify the hypothesis; and circuitry for executing one or more actions based, at least in part, on a modified hypothesis resulting, at least in part, from the reception of the one or more modifications. In addition to the foregoing, other system aspects are described in the claims, drawings, and text forming a part of the present disclosure.

A computer program product including a signal-bearing medium bearing one or more instructions presenting to a user a hypothesis identifying at least a relationship between a first event type and a second event type; one or more instructions for receiving from the user one or more modifications to modify the hypothesis; and one or more instructions for executing one or more actions based, at least in part, on a modified hypothesis resulting, at least in part, from the reception of the one or more modifications. In addition to the foregoing, other computer program product aspects are described in the claims, drawings, and text forming a part of the present disclosure.

The foregoing summary is illustrative only and is not intended to be in any way limiting. In addition to the illustrative aspects, embodiments, and features described above, further aspects, embodiments, and features will become apparent by reference to the drawings and the following detailed description.

A computationally implemented method includes, but is not limited to: acquiring subjective user state data including at least a first subjective user state and a second subjective user state; acquiring objective context data including at least a first context data indicative of a first objective occurrence associated with a user and a second context data indicative of a second objective occurrence associated with the user; and correlating the subjective user state data with the objective context data. In addition to the foregoing, other method aspects are described in the claims, drawings, and text forming a part of the present disclosure.

In one or more various aspects, related systems include but are not limited to circuitry and/or programming for effecting the herein referenced method aspects; the circuitry and/or programming can be virtually any combination of hardware, software, and/or firmware configured to effect the herein referenced method aspects depending upon the design choices of the system designer.

A computationally implemented system includes, but is not limited to: means for acquiring subjective user state data including at least a first subjective user state and a second subjective user state; means for acquiring objective context data including at least a first context data indicative of a first objective occurrence associated with a user and a second context data indicative of a second objective occurrence associated with the user; and means for correlating the subjective user state data with the objective context data. In addition to the foregoing, other system aspects are described in the claims, drawings, and text forming a part of the present disclosure.

A computationally implemented system includes, but is not limited to: circuitry for acquiring subjective user state data including at least a first subjective user state and a second subjective user state; circuitry for acquiring objective context data including at least a first context data indicative of a first objective occurrence associated with a user and a second context data indicative of a second objective occurrence associated with the user; and circuitry for correlating the subjective user state data with the objective context data. In addition to the foregoing, other system aspects are described in the claims, drawings, and text forming a part of the present disclosure.

A computer program product including a signal-bearing medium bearing one or more instructions for acquiring subjective user state data including at least a first subjective user state and a second subjective user state; one or more instructions for acquiring objective context data including at least a first context data indicative of a first objective occurrence associated with a user and a second context data indicative of a second objective occurrence associated with the user; and one or more instructions for correlating the subjective user state data with the objective context data. In addition to the foregoing, other computer program product aspects are described in the claims, drawings, and text forming a part of the present disclosure.

The foregoing summary is illustrative only and is not intended to be in any way limiting. In addition to the illustrative aspects, embodiments, and features described above, further aspects, embodiments, and features will become apparent by reference to the drawings and the following detailed description.

A computationally implemented method includes, but is not limited to: acquiring subjective user state data including data indicating at least one subjective user state associated with a user; acquiring objective occurrence data including data indicating at least one objective occurrence associated with the user; correlating the subjective user state data with the objective occurrence data based, at least in part, on a determination of at least one sequential pattern associated with the at least one subjective user state and the at least one objective occurrence; and presenting one or more results of the correlating. In addition to the foregoing, other method aspects are described in the claims, drawings, and text forming a part of the present disclosure.

In one or more various aspects, related systems include but are not limited to circuitry and/or programming for effecting the herein referenced method aspects; the circuitry and/or programming can be virtually any combination of hardware, software, and/or firmware configured to effect the herein referenced method aspects depending upon the design choices of the system designer.

A computationally implemented system includes, but is not limited to: means for acquiring subjective user state data including data indicating at least one subjective user state associated with a user; means for acquiring objective occurrence data including data indicating at least one objective occurrence associated with the user; means for correlating the subjective user state data with the objective occurrence data based, at least in part, on a determination of at least one sequential pattern associated with the at least one subjective user state and the at least one objective occurrence; and means for presenting one or more results of the correlating. In addition to the foregoing, other system aspects are described in the claims, drawings, and text forming a part of the present disclosure.

A computationally implemented system includes, but is not limited to: circuitry for acquiring subjective user state data including data indicating at least one subjective user state associated with a user; circuitry for acquiring objective occurrence data including data indicating at least one objective occurrence associated with the user; circuitry for correlating the subjective user state data with the objective occurrence data based, at least in part, on a determination of at least one sequential pattern associated with the at least one subjective user state and the at least one objective occurrence; and circuitry for presenting one or more results of the correlating. In addition to the foregoing, other system aspects are described in the claims, drawings, and text forming a part of the present disclosure.

A computer program product including a signal-bearing medium bearing one or more instructions for acquiring subjective user state data including data indicating at least one subjective user state associated with a user; one or more instructions for acquiring objective occurrence data including data indicating at least one objective occurrence associated with the user; one or more instructions for correlating the subjective user state data with the objective occurrence data based, at least in part, on a determination of at least one sequential pattern associated with the at least one subjective user state and the at least one objective occurrence; and one or more instructions for presenting one or more results of the correlating. In addition to the foregoing, other computer program product aspects are described in the claims, drawings, and text forming a part of the present disclosure.

The foregoing summary is illustrative only and is not intended to be in any way limiting. In addition to the illustrative aspects, embodiments, and features described above, further aspects, embodiments, and features will become apparent by reference to the drawings and the following detailed description.

A computationally implemented method includes, but is not limited to: acquiring subjective user state data including data indicating at least one subjective user state associated with a user; soliciting, in response to the acquisition of the subjective user state data, objective occurrence data including data indicating occurrence of at least one objective occurrence; acquiring the objective occurrence data; and correlating the subjective user state data with the objective occurrence data. In addition to the foregoing, other method aspects are described in the claims, drawings, and text forming a part of the present disclosure.

In one or more various aspects, related systems include but are not limited to circuitry and/or programming for effecting the herein referenced method aspects; the circuitry and/or programming can be virtually any combination of hardware, software, and/or firmware configured to effect the herein referenced method aspects depending upon the design choices of the system designer.

A computationally implemented system includes, but is not limited to: means for acquiring subjective user state data including data indicating at least one subjective user state associated with a user; means for soliciting, in response to the acquisition of the subjective user state data, objective occurrence data including data indicating occurrence of at least one objective occurrence; means for acquiring the objective occurrence data; and means for correlating the subjective user state data with the objective occurrence data. In addition to the foregoing, other system aspects are described in the claims, drawings, and text forming a part of the present disclosure.

A computationally implemented system includes, but is not limited to: circuitry for acquiring subjective user state data including data indicating at least one subjective user state associated with a user; circuitry for soliciting, in response to the acquisition of the subjective user state data, objective occurrence data including data indicating occurrence of at least one objective occurrence; circuitry for acquiring the objective occurrence data; and circuitry for correlating the subjective user state data with the objective occurrence data. In addition to the foregoing, other system aspects are described in the claims, drawings, and text forming a part of the present disclosure.

A computer program product including a signal-bearing medium bearing one or more instructions for acquiring subjective user state data including data indicating at least one subjective user state associated with a user; one or more instructions for soliciting, in response to the acquisition of the subjective user state data, objective occurrence data including data indicating occurrence of at least one objective occurrence; one or more instructions for acquiring the objective occurrence data; and one or more instructions for correlating the subjective user state data with the objective occurrence data. In addition to the foregoing, other computer program product aspects are described in the claims, drawings, and text forming a part of the present disclosure.

The foregoing summary is illustrative only and is not intended to be in any way limiting. In addition to the illustrative aspects, embodiments, and features described above, further aspects, embodiments, and features will become apparent by reference to the drawings and the following detailed description.

A computationally implemented method includes, but is not limited to: acquiring objective occurrence data including data indicating occurrence of at least one objective occurrence; soliciting, in response to the acquisition of the objective occurrence data, subjective user state data including data indicating occurrence of at least one subjective user state associated with a user; acquiring the subjective user state data; and correlating the subjective user state data with the objective occurrence data. In addition to the foregoing, other method aspects are described in the claims, drawings, and text forming a part of the present disclosure.

In one or more various aspects, related systems include but are not limited to circuitry and/or programming for effecting the herein referenced method aspects; the circuitry and/or programming can be virtually any combination of hardware, software, and/or firmware configured to effect the herein referenced method aspects depending upon the design choices of the system designer.

A computationally implemented system includes, but is not limited to: means for acquiring objective occurrence data including data indicating occurrence of at least one objective occurrence; means for soliciting, in response to the acquisition of the objective occurrence data, subjective user state data including data indicating occurrence of at least one subjective user state associated with a user; means for acquiring the subjective user state data; and means for correlating the subjective user state data with the objective occurrence data. In addition to the foregoing, other system aspects are described in the claims, drawings, and text forming a part of the present disclosure.

A computationally implemented system includes, but is not limited to: circuitry for acquiring objective occurrence data including data indicating occurrence of at least one objective occurrence; circuitry for soliciting, in response to the acquisition of the objective occurrence data, subjective user state data including data indicating occurrence of at least one subjective user state associated with a user; circuitry for acquiring the subjective user state data; and circuitry for correlating the subjective user state data with the objective occurrence data. In addition to the foregoing, other system aspects are described in the claims, drawings, and text forming a part of the present disclosure.

A computer program product including a signal-bearing medium bearing one or more instructions for acquiring objective occurrence data including data indicating occurrence of at least one objective occurrence; one or more instructions for soliciting, in response to the acquisition of the objective occurrence data, subjective user state data including data indicating occurrence of at least one subjective user state associated with a user; one or more instructions for acquiring the subjective user state data; and one or more instructions for correlating the subjective user state data with the objective occurrence data. In addition to the foregoing, other computer program product aspects are described in the claims, drawings, and text forming a part of the present disclosure.

The foregoing summary is illustrative only and is not intended to be in any way limiting. In addition to the illustrative aspects, embodiments, and features described above, further aspects, embodiments, and features will become apparent by reference to the drawings and the following detailed description.

A computationally implemented method includes, but is not limited to: acquiring subjective user state data including data indicating incidence of at least a first subjective user state associated with a first user and data indicating incidence of at least a second subjective user state associated with a second user; acquiring objective occurrence data including data indicating incidence of at least a first objective occurrence and data indicating incidence of at least a second objective occurrence; and correlating the subjective user state data with the objective occurrence data. In addition to the foregoing, other method aspects are described in the claims, drawings, and text forming a part of the present disclosure.

In one or more various aspects, related systems include but are not limited to circuitry and/or programming for effecting the herein referenced method aspects; the circuitry and/or programming can be virtually any combination of hardware, software, and/or firmware configured to effect the herein referenced method aspects depending upon the design choices of the system designer.

A computationally implemented system includes, but is not limited to: means for acquiring subjective user state data including data indicating incidence of at least a first subjective user state associated with a first user and data indicating incidence of at least a second subjective user state associated with a second user; means for acquiring objective occurrence data including data indicating incidence of at least a first objective occurrence and data indicating incidence of at least a second objective occurrence; and means for correlating the subjective user state data with the objective occurrence data. In addition to the foregoing, other system aspects are described in the claims, drawings, and text forming a part of the present disclosure.

A computationally implemented system includes, but is not limited to: circuitry for acquiring subjective user state data including data indicating incidence of at least a first subjective user state associated with a first user and data indicating incidence of at least a second subjective user state associated with a second user; circuitry for acquiring objective occurrence data including data indicating incidence of at least a first objective occurrence and data indicating incidence of at least a second objective occurrence; and circuitry for correlating the subjective user state data with the objective occurrence data. In addition to the foregoing, other system aspects are described in the claims, drawings, and text forming a part of the present disclosure.

A computer program product including a signal-bearing medium bearing one or more instructions for acquiring subjective user state data including data indicating incidence of at least a first subjective user state associated with a first user and data indicating incidence of at least a second subjective user state associated with a second user; one or more instructions for acquiring objective occurrence data including data indicating incidence of at least a first objective occurrence and data indicating incidence of at least a second objective occurrence; and one or more instructions for correlating the subjective user state data with the objective occurrence data. In addition to the foregoing, other computer program product aspects are described in the claims, drawings, and text forming a part of the present disclosure.

The foregoing summary is illustrative only and is not intended to be in any way limiting. In addition to the illustrative aspects, embodiments, and features described above, further aspects, embodiments, and features will become apparent by reference to the drawings and the following detailed description.

A computationally implemented method includes, but is not limited to soliciting, based at least in part on a hypothesis that links one or more objective occurrences with one or more subjective user states and in response at least in part to an incidence of at least one objective occurrence, subjective user state data including data indicating incidence of at least one subjective user state associated with a user; and acquiring the subjective user state data including the data indicating incidence of at least one subjective user state associated with the user. In addition to the foregoing, other method aspects are described in the claims, drawings, and text forming a part of the present disclosure.

In one or more various aspects, related systems include but are not limited to circuitry and/or programming for effecting the herein referenced method aspects; the circuitry and/or programming can be virtually any combination of hardware, software, and/or firmware configured to effect the herein referenced method aspects depending upon the design choices of the system designer.

A computationally implemented system includes, but is not limited to: means for soliciting, based at least in part on a hypothesis that links one or more objective occurrences with one or more subjective user states and in response at least in part to an incidence of at least one objective occurrence, subjective user state data including data indicating incidence of at least one subjective user state associated with a user; and means for acquiring the subjective user state data including the data indicating incidence of at least one subjective user state associated with the user. In addition to the foregoing, other system aspects are described in the claims, drawings, and text forming a part of the present disclosure.

A computationally implemented system includes, but is not limited to: circuitry for soliciting, based at least in part on a hypothesis that links one or more objective occurrences with one or more subjective user states and in response at least in part to an incidence of at least one objective occurrence, subjective user state data including data indicating incidence of at least one subjective user state associated with a user; and circuitry for acquiring the subjective user state data including the data indicating incidence of at least one subjective user state associated with the user. In addition to the foregoing, other system aspects are described in the claims, drawings, and text forming a part of the present disclosure.

A computer program product including a signal-bearing medium bearing one or more instructions soliciting, based at least in part on a hypothesis that links one or more objective occurrences with one or more subjective user states and in response at least in part to an incidence of at least one objective occurrence, subjective user state data including data indicating incidence of at least one subjective user state associated with a user; and one or more instructions for acquiring the subjective user state data including the data indicating incidence of at least one subjective user state associated with the user. In addition to the foregoing, other computer program product aspects are described in the claims, drawings, and text forming a part of the present disclosure.

The foregoing summary is illustrative only and is not intended to be in any way limiting. In addition to the illustrative aspects, embodiments, and features described above, further aspects, embodiments, and features will become apparent by reference to the drawings and the following detailed description.

A computationally implemented method includes, but is not limited to soliciting, based at least in part on a hypothesis that links one or more objective occurrences with one or more subjective user states and in response at least in part to an incidence of at least one subjective user state associated with a user, at least a portion of objective occurrence data including data indicating incidence of at least one objective occurrence; and acquiring the objective occurrence data including the data indicating incidence of at least one objective occurrence. In addition to the foregoing, other method aspects are described in the claims, drawings, and text forming a part of the present disclosure.

In one or more various aspects, related systems include but are not limited to circuitry and/or programming for effecting the herein referenced method aspects; the circuitry and/or programming can be virtually any combination of hardware, software, and/or firmware configured to effect the herein referenced method aspects depending upon the design choices of the system designer.

A computationally implemented system includes, but is not limited to: means for soliciting, based at least in part on a hypothesis that links one or more objective occurrences with one or more subjective user states and in response at least in part to an incidence of at least one subjective user state associated with a user, at least a portion of objective occurrence data including data indicating incidence of at least one objective occurrence; and means for acquiring the objective occurrence data including the data indicating incidence of at least one objective occurrence. In addition to the foregoing, other system aspects are described in the claims, drawings, and text forming a part of the present disclosure.

A computationally implemented system includes, but is not limited to: circuitry for soliciting, based at least in part on a hypothesis that links one or more objective occurrences with one or more subjective user states and in response at least in part to an incidence of at least one subjective user state associated with a user, at least a portion of objective occurrence data including data indicating incidence of at least one objective occurrence; and circuitry for acquiring the objective occurrence data including the data indicating incidence of at least one objective occurrence. In addition to the foregoing, other system aspects are described in the claims, drawings, and text forming a part of the present disclosure.

A computer program product including a signal-bearing medium bearing one or more instructions for soliciting, based at least in part on a hypothesis that links one or more objective occurrences with one or more subjective user states and in response at least in part to an incidence of at least one subjective user state associated with a user, at least a portion of objective occurrence data including data indicating incidence of at least one objective occurrence; and one or more instructions for acquiring the objective occurrence data including the data indicating incidence of at least one objective occurrence. In addition to the foregoing, other computer program product aspects are described in the claims, drawings, and text forming a part of the present disclosure.

The foregoing summary is illustrative only and is not intended to be in any way limiting. In addition to the illustrative aspects, embodiments, and features described above, further aspects, embodiments, and features will become apparent by reference to the drawings and the following detailed description.

A computationally implemented method includes, but is not limited to acquiring events data including data indicating incidence of a first one or more reported events and data indicating incidence of a second one or more reported events, at least one of the first one or more reported events and the second one or more reported events being associated with a user; determining an events pattern based selectively on the incidences of the first one or more reported events and the second one or more reported events; and developing a hypothesis associated with the user based, at least in part, on the determined events pattern. In addition to the foregoing, other method aspects are described in the claims, drawings, and text forming a part of the present disclosure.

In one or more various aspects, related systems include but are not limited to circuitry and/or programming for effecting the herein referenced method aspects; the circuitry and/or programming can be virtually any combination of hardware, software, and/or firmware configured to effect the herein referenced method aspects depending upon the design choices of the system designer.

A computationally implemented system includes, but is not limited to: means for acquiring events data including data indicating incidence of a first one or more reported events and data indicating incidence of a second one or more reported events, at least one of the first one or more reported events and the second one or more reported events being associated with a user; means for determining an events pattern based selectively on the incidences of the first one or more reported events and the second one or more reported events; and means for developing a hypothesis associated with the user based, at least in part, on the determined events pattern. In addition to the foregoing, other system aspects are described in the claims, drawings, and text forming a part of the present disclosure.

A computationally implemented system includes, but is not limited to: circuitry for acquiring events data including data indicating incidence of a first one or more reported events and data indicating incidence of a second one or more reported events, at least one of the first one or more reported events and the second one or more reported events being associated with a user; circuitry for determining an events pattern based selectively on the incidences of the first one or more reported events and the second one or more reported events; and circuitry for developing a hypothesis associated with the user based, at least in part, on the determined events pattern. In addition to the foregoing, other system aspects are described in the claims, drawings, and text forming a part of the present disclosure.

A computer program product including a signal-bearing medium bearing one or more instructions acquiring events data including data indicating incidence of a first one or more reported events and data indicating incidence of a second one or more reported events, at least one of the first one or more reported events and the second one or more reported events being associated with a user; one or more instructions for determining an events pattern based selectively on the incidences of the first one or more reported events and the second one or more reported events; and one or more instructions for developing a hypothesis associated with the user based, at least in part, on the determined events pattern. In addition to the foregoing, other computer program product aspects are described in the claims, drawings, and text forming a part of the present disclosure.

The foregoing summary is illustrative only and is not intended to be in any way limiting. In addition to the illustrative aspects, embodiments, and features described above, further aspects, embodiments, and features will become apparent by reference to the drawings and the following detailed description.

A computationally implemented method includes, but is not limited to selecting at least one hypothesis from a plurality of hypotheses relevant to a user, the selection of the at least one hypothesis being based, at least in part, on at least one reported event associated with the user; and presenting one or more advisories related to the hypothesis. In addition to the foregoing, other method aspects are described in the claims, drawings, and text forming a part of the present disclosure.

In one or more various aspects, related systems include but are not limited to circuitry and/or programming for effecting the herein referenced method aspects; the circuitry and/or programming can be virtually any combination of hardware, software, and/or firmware configured to effect the herein referenced method aspects depending upon the design choices of the system designer.

A computationally implemented system includes, but is not limited to: means for selecting at least one hypothesis from a plurality of hypotheses relevant to a user, the selection of the at least one hypothesis being based, at least in part, on at least one reported event associated with the user; and means for presenting one or more advisories related to the hypothesis. In addition to the foregoing, other system aspects are described in the claims, drawings, and text forming a part of the present disclosure.

A computationally implemented system includes, but is not limited to: circuitry for selecting at least one hypothesis from a plurality of hypotheses relevant to a user, the selection of the at least one hypothesis being based, at least in part, on at least one reported event associated with the user; and circuitry for presenting one or more advisories related to the hypothesis. In addition to the foregoing, other system aspects are described in the claims, drawings, and text forming a part of the present disclosure.

A computer program product including a signal-bearing medium bearing one or more instructions selecting at least one hypothesis from a plurality of hypotheses relevant to a user, the selection of the at least one hypothesis being based, at least in part, on at least one reported event associated with the user; and one or more instructions for presenting one or more advisories related to the hypothesis. In addition to the foregoing, other computer program product aspects are described in the claims, drawings, and text forming a part of the present disclosure.

The foregoing summary is illustrative only and is not intended to be in any way limiting. In addition to the illustrative aspects, embodiments, and features described above, further aspects, embodiments, and features will become apparent by reference to the drawings and the following detailed description.

A computationally implemented method includes, but is not limited to acquiring a first data indicating at least one reported event as originally reported by a user and a second data indicating at least a second reported event as originally reported by one or more sensing devices; and developing a hypothesis based, at least in part, on the first data and the second data. In addition to the foregoing, other method aspects are described in the claims, drawings, and text forming a part of the present disclosure.

In one or more various aspects, related systems include but are not limited to circuitry and/or programming for effecting the herein referenced method aspects; the circuitry and/or programming can be virtually any combination of hardware, software, and/or firmware configured to effect the herein referenced method aspects depending upon the design choices of the system designer.

A computationally implemented system includes, but is not limited to: means for acquiring a first data indicating at least one reported event as originally reported by a user and a second data indicating at least a second reported event as originally reported by one or more sensing devices; and means for developing a hypothesis based, at least in part, on the first data and the second data. In addition to the foregoing, other system aspects are described in the claims, drawings, and text forming a part of the present disclosure.

A computationally implemented system includes, but is not limited to: circuitry for acquiring a first data indicating at least one reported event as originally reported by a user and a second data indicating at least a second reported event as originally reported by one or more sensing devices; and circuitry for developing a hypothesis based, at least in part, on the first data and the second data. In addition to the foregoing, other system aspects are described in the claims, drawings, and text forming a part of the present disclosure.

A computer program product including a signal-bearing medium bearing one or more instructions acquiring a first data indicating at least one reported event as originally reported by a user and a second data indicating at least a second reported event as originally reported by one or more sensing devices; and one or more instructions for developing a hypothesis based, at least in part, on the first data and the second data. In addition to the foregoing, other computer program product aspects are described in the claims, drawings, and text forming a part of the present disclosure.

The foregoing summary is illustrative only and is not intended to be in any way limiting. In addition to the illustrative aspects, embodiments, and features described above, further aspects, embodiments, and features will become apparent by reference to the drawings and the following detailed description.

### BRIEF DESCRIPTION OF THE FIGURES

FIGS. 1a and 1b show a high-level block diagram a computing device 10 and a mobile device 30 operating in a network environment.

FIG. 2a shows another perspective of the hypothesis presentation module 102 of the computing device 10 of FIG. 1b.

FIG. 2b shows another perspective of the modification reception module 104 of the computing device 10 of FIG. 1b.

FIG. 2c shows another perspective of the action execution module 108 of the computing device 10 of FIG. 1b.

FIG. 2d shows another perspective of the mobile device 30 of FIG. 1a.

FIG. 2e shows another perspective of the hypothesis presentation module 102′ of the mobile device 30 of FIG. 2d.

FIG. 2f shows another perspective of the modification reception module 104′ of the mobile device 30 of FIG. 2d.

FIG. 2g shows another perspective of the action execution module 108′ of the mobile device 30 of FIG. 2d.

FIG. 2h shows an exemplarily user interface display displaying a visual version of a hypothesis.

FIG. 2i shows another exemplarily user interface display displaying another visual version of the hypothesis.

FIG. 2j shows another exemplarily user interface display displaying still another visual version of the hypothesis.

FIG. 2k shows another exemplarily user interface display displaying a visual version of another hypothesis.

FIG. 3 is a high-level logic flowchart of a process.

FIG. 4a is a high-level logic flowchart of a process depicting alternate implementations of the hypothesis presentation operation 302 of FIG. 3.

FIG. 4b is a high-level logic flowchart of a process depicting alternate implementations of the hypothesis presentation operation 302 of FIG. 3.

FIG. 4c is a high-level logic flowchart of a process depicting alternate implementations of the hypothesis presentation operation 302 of FIG. 3.

FIG. 4d is a high-level logic flowchart of a process depicting alternate implementations of the hypothesis presentation operation 302 of FIG. 3.

FIG. 4e is a high-level logic flowchart of a process depicting alternate implementations of the hypothesis presentation operation 302 of FIG. 3.

FIG. 4f is a high-level logic flowchart of a process depicting alternate implementations of the hypothesis presentation operation 302 of FIG. 3.

FIG. 5a is a high-level logic flowchart of a process depicting alternate implementations of the modification reception operation 304 of FIG. 3.

FIG. 5b is a high-level logic flowchart of a process depicting alternate implementations of the modification reception operation 304 of FIG. 3.

FIG. 6a is a high-level logic flowchart of a process depicting alternate implementations of the action execution operation 306 of FIG. 3.

FIG. 6b is a high-level logic flowchart of a process depicting alternate implementations of the action execution operation 306 of FIG. 3.

FIG. 6c is a high-level logic flowchart of a process depicting alternate implementations of the action execution operation 306 of FIG. 3.

FIG. 6d is a high-level logic flowchart of a process depicting alternate implementations of the action execution operation 306 of FIG. 3.

FIG. 6e is a high-level logic flowchart of a process depicting alternate implementations of the action execution operation 306 of FIG. 3.

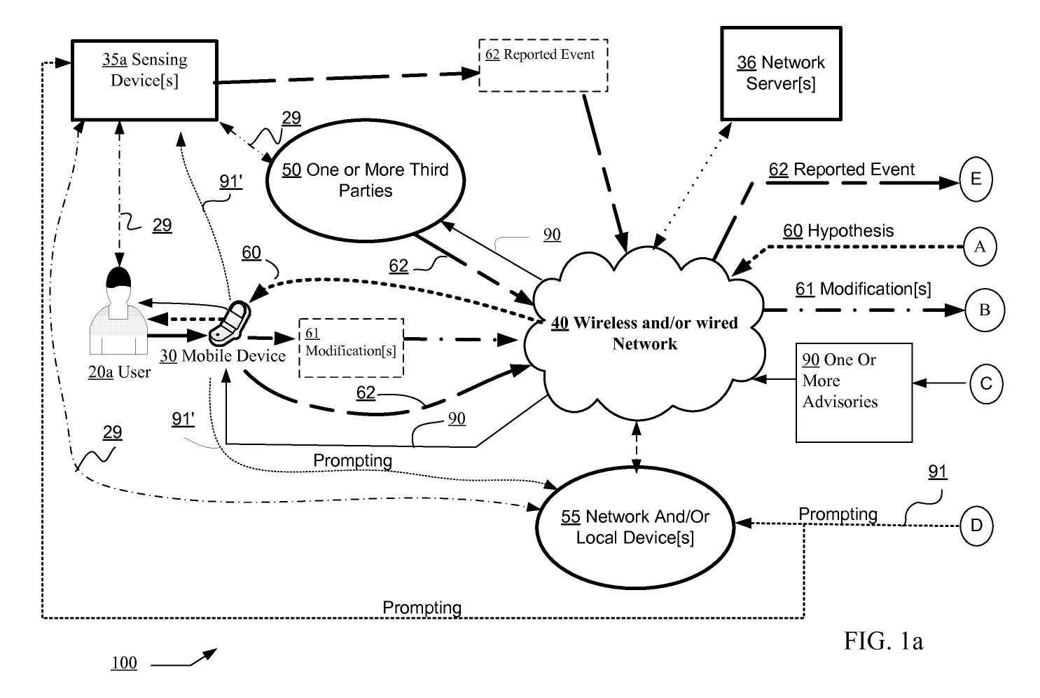

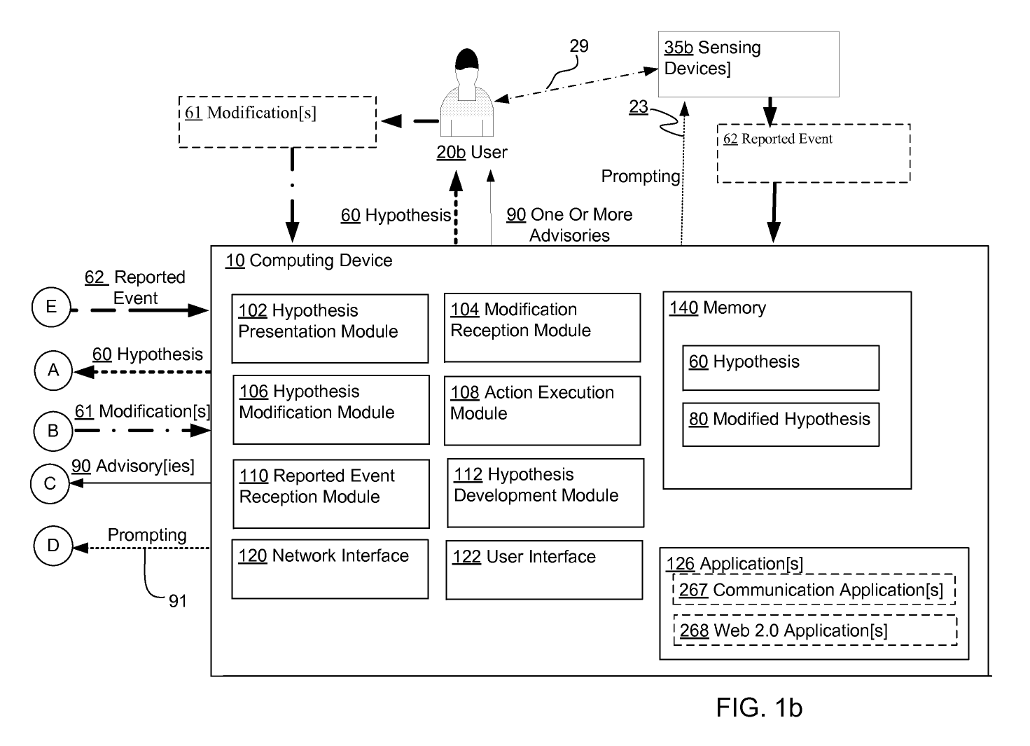

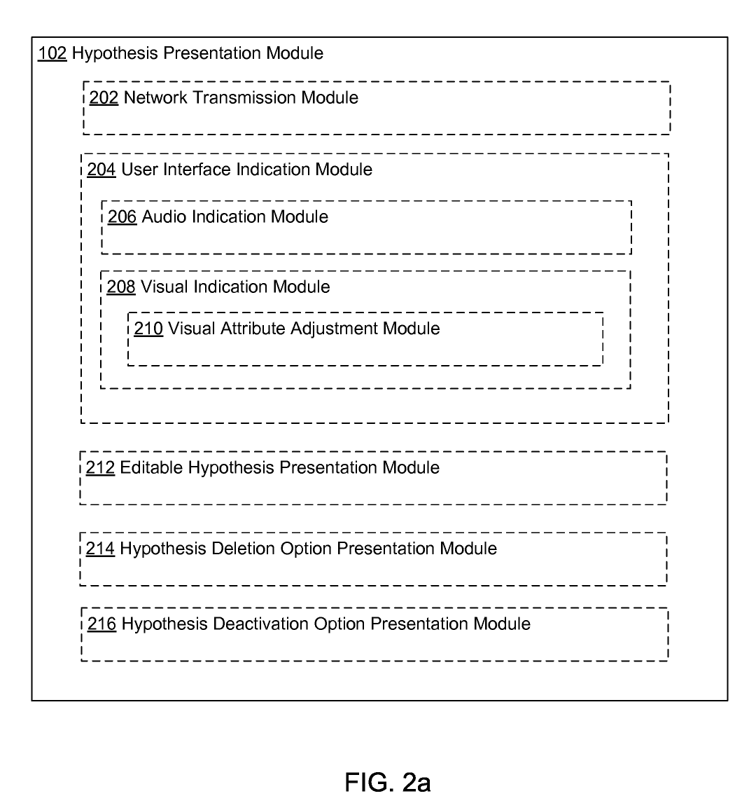

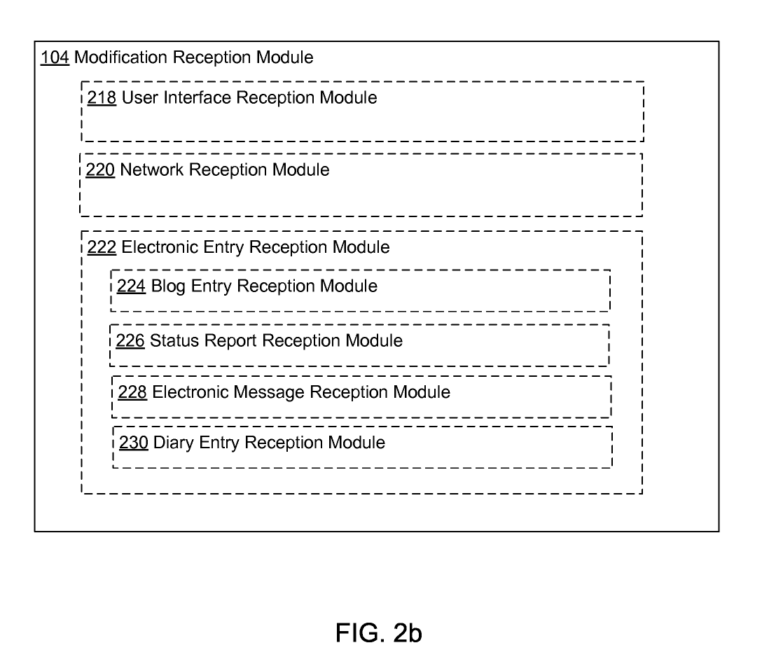

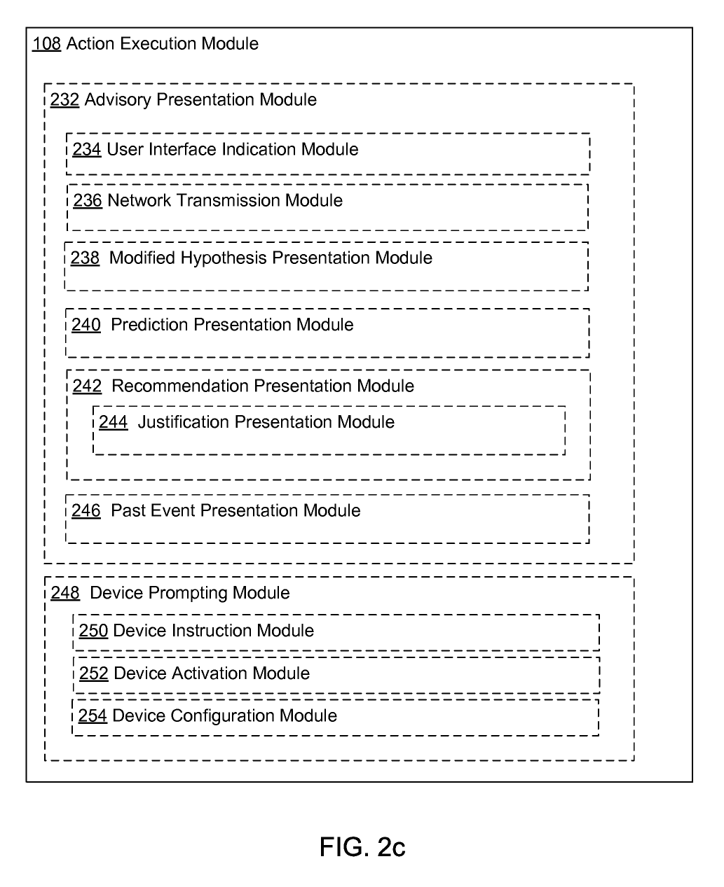

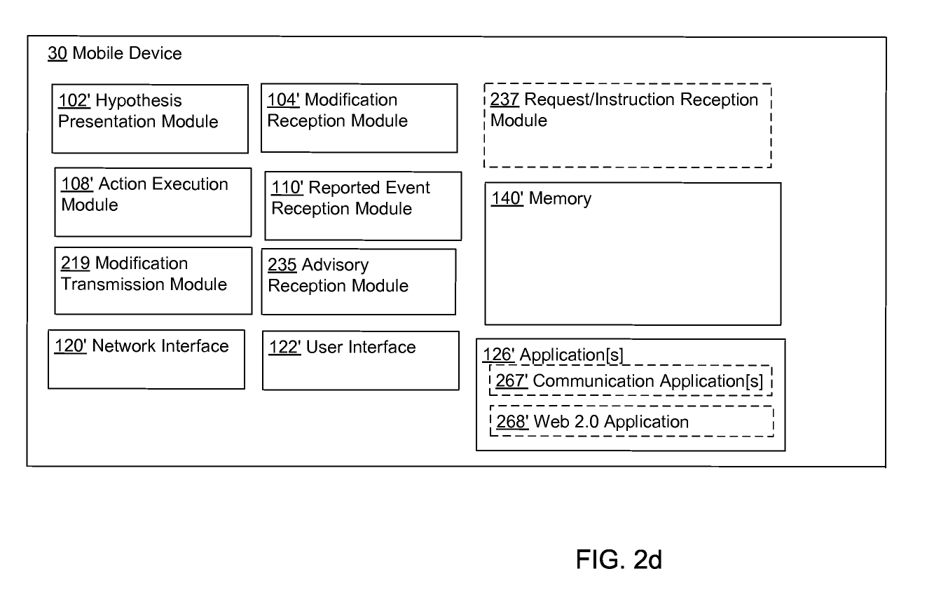

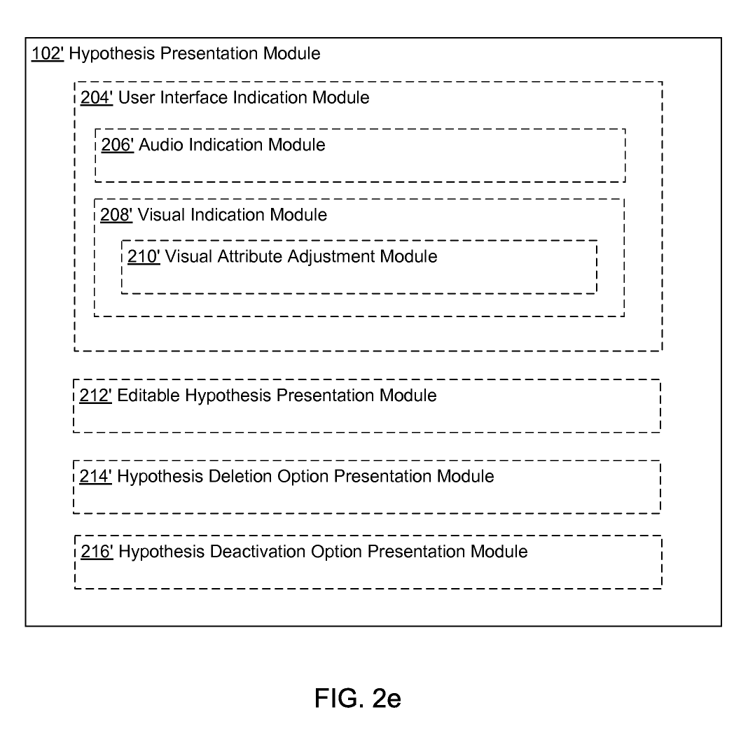

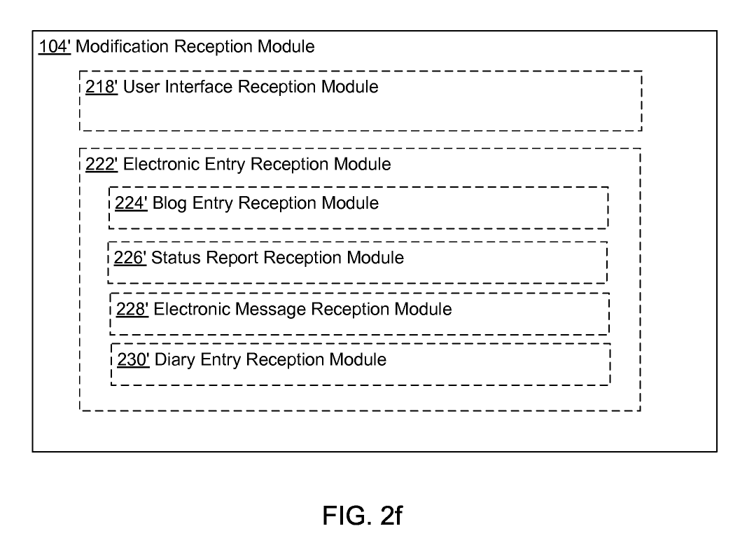

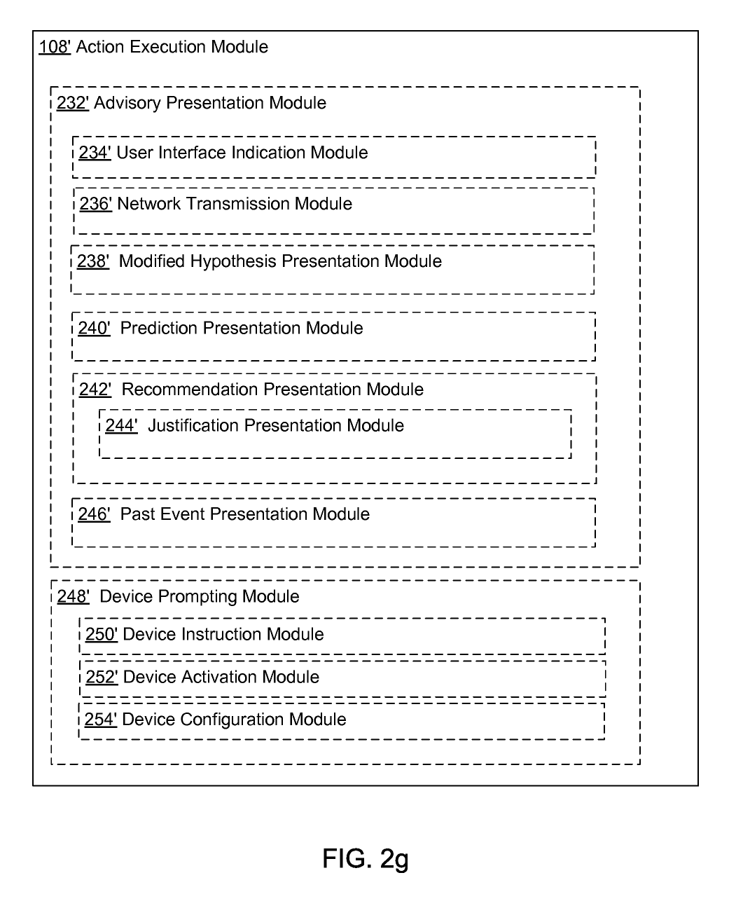

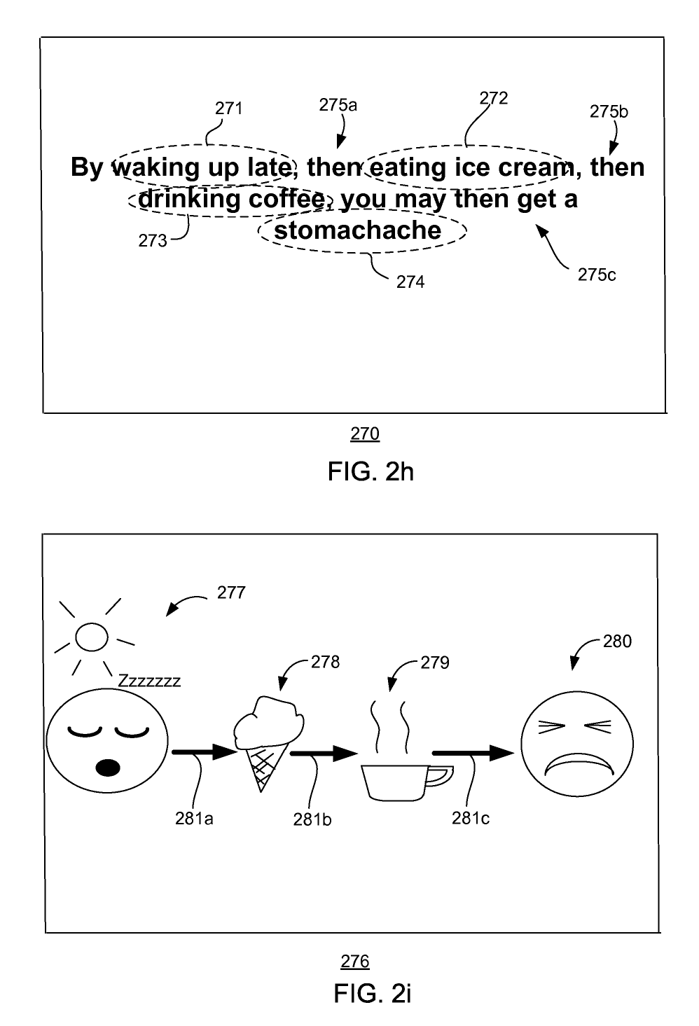

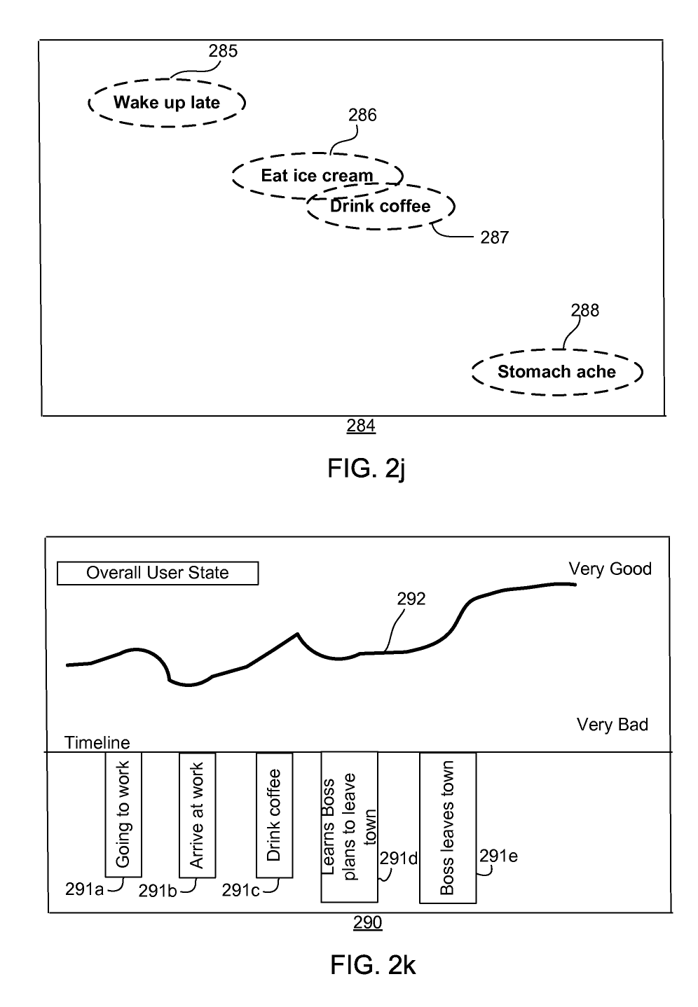

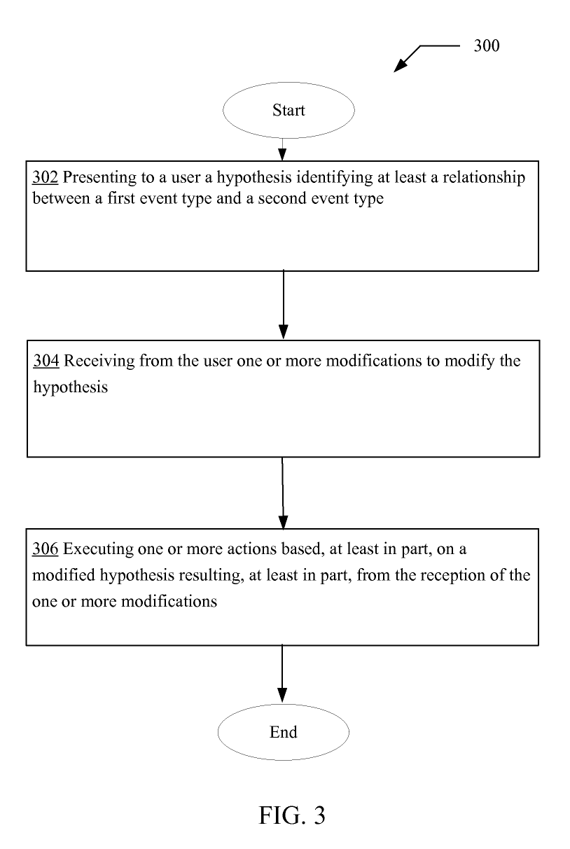

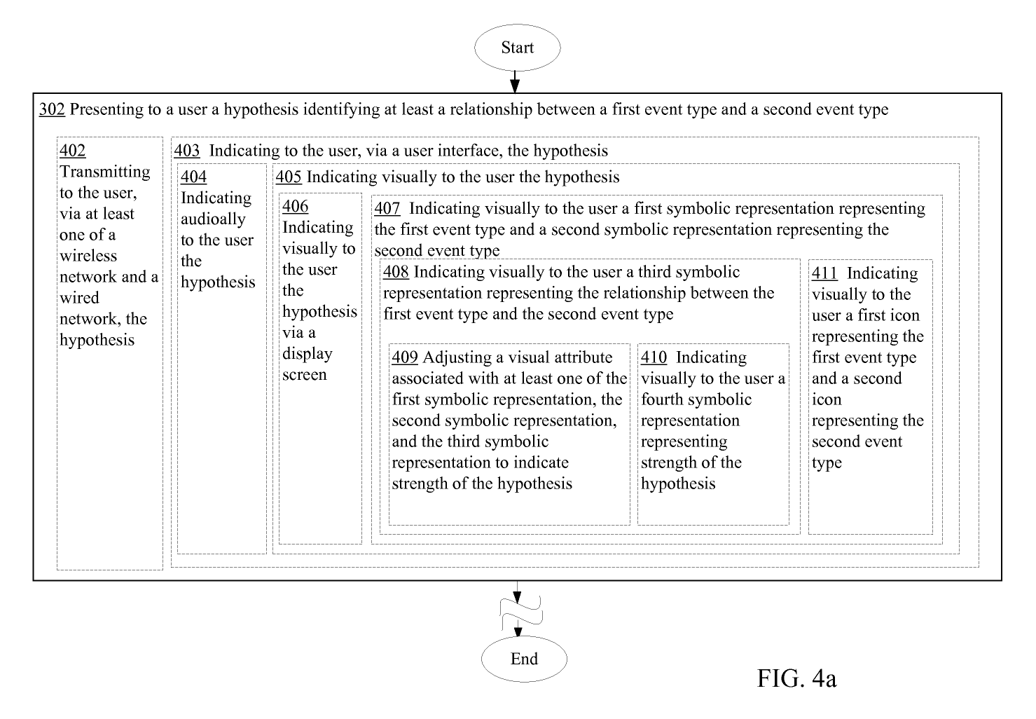

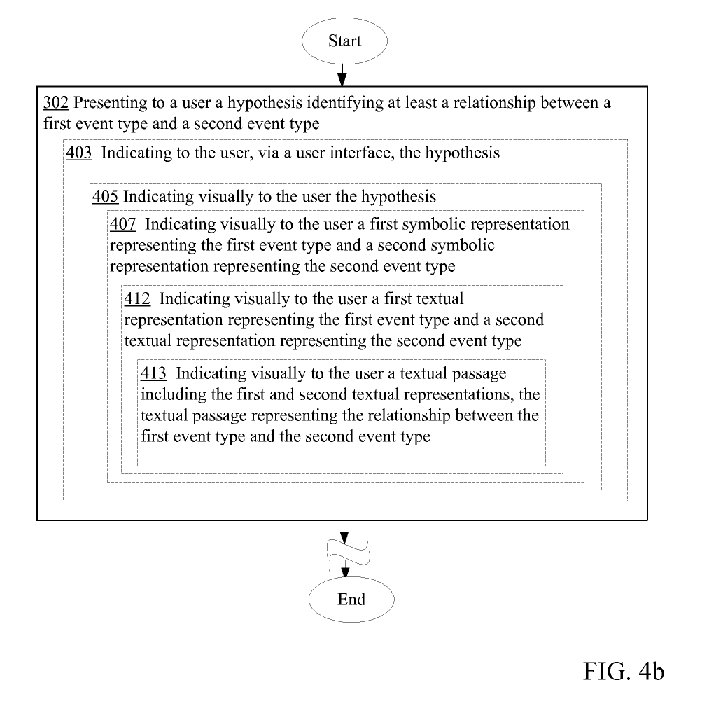

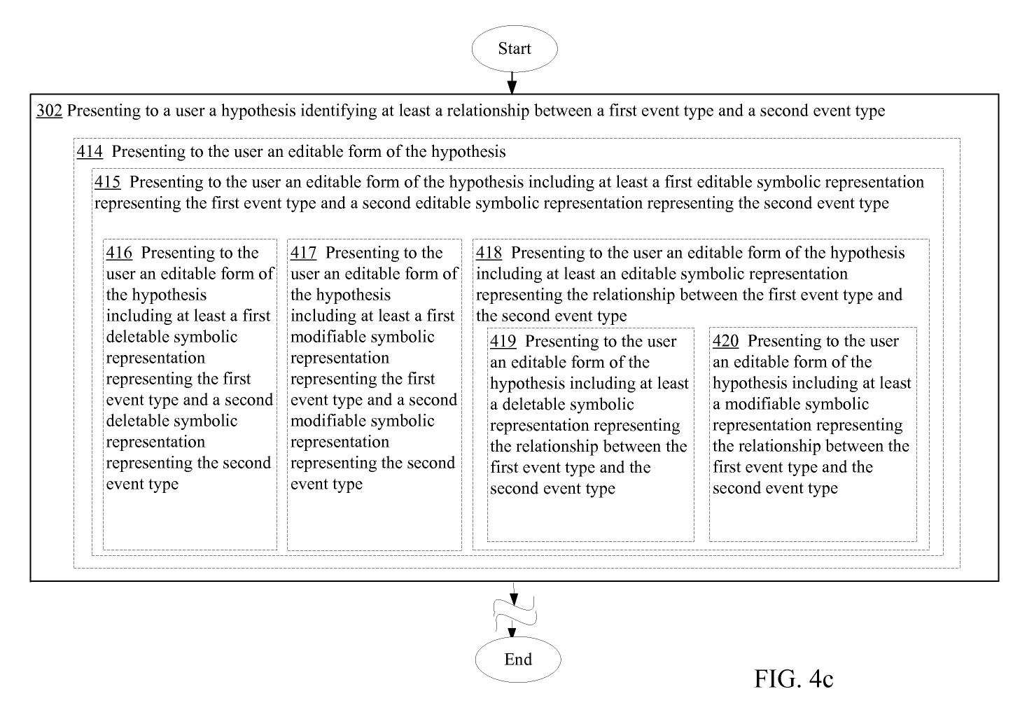

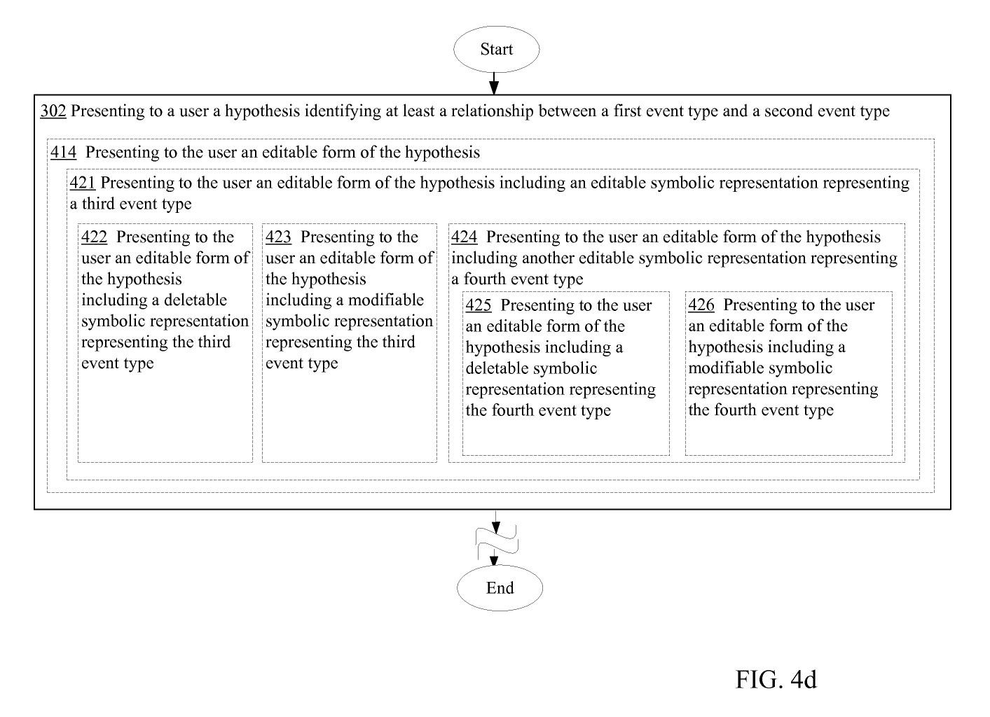

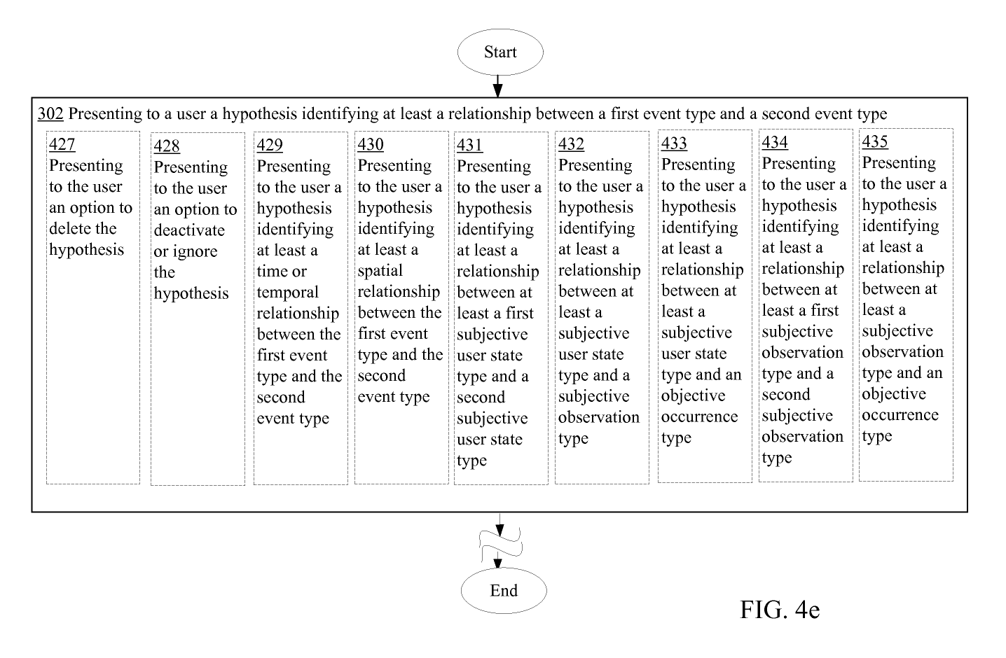

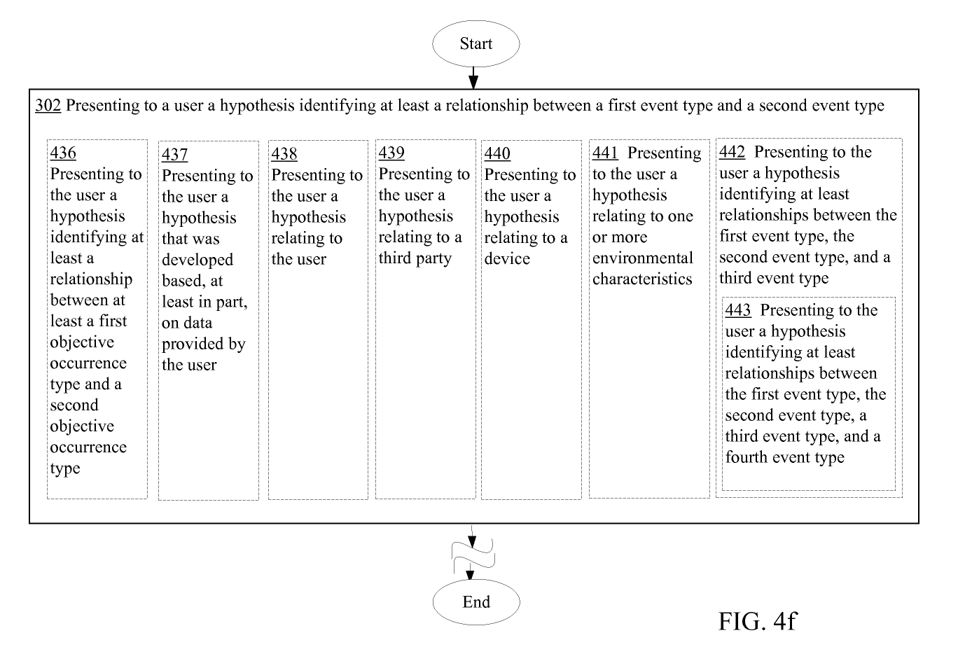

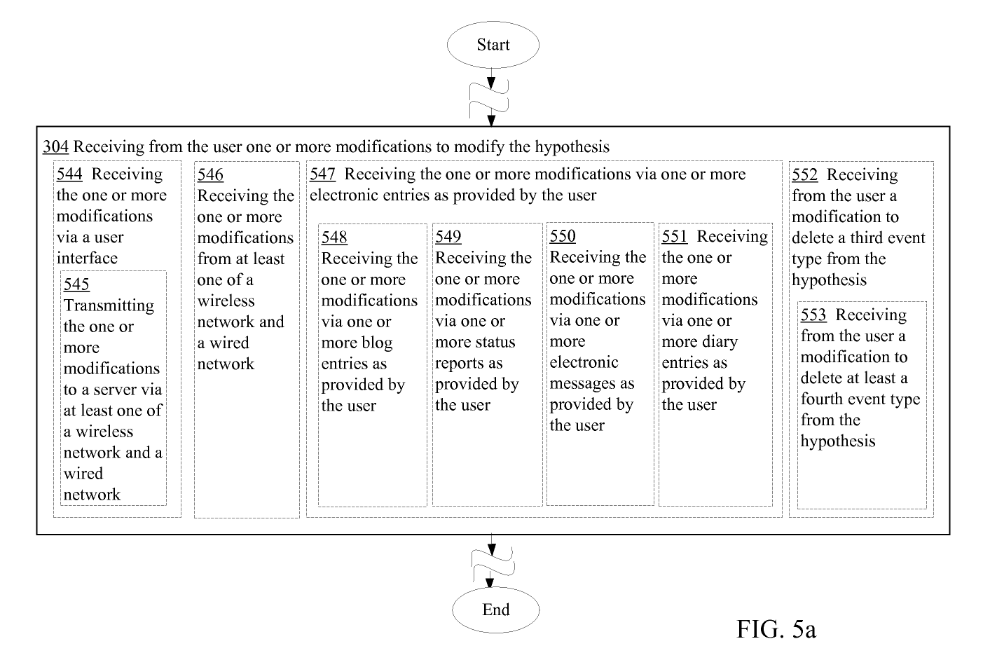

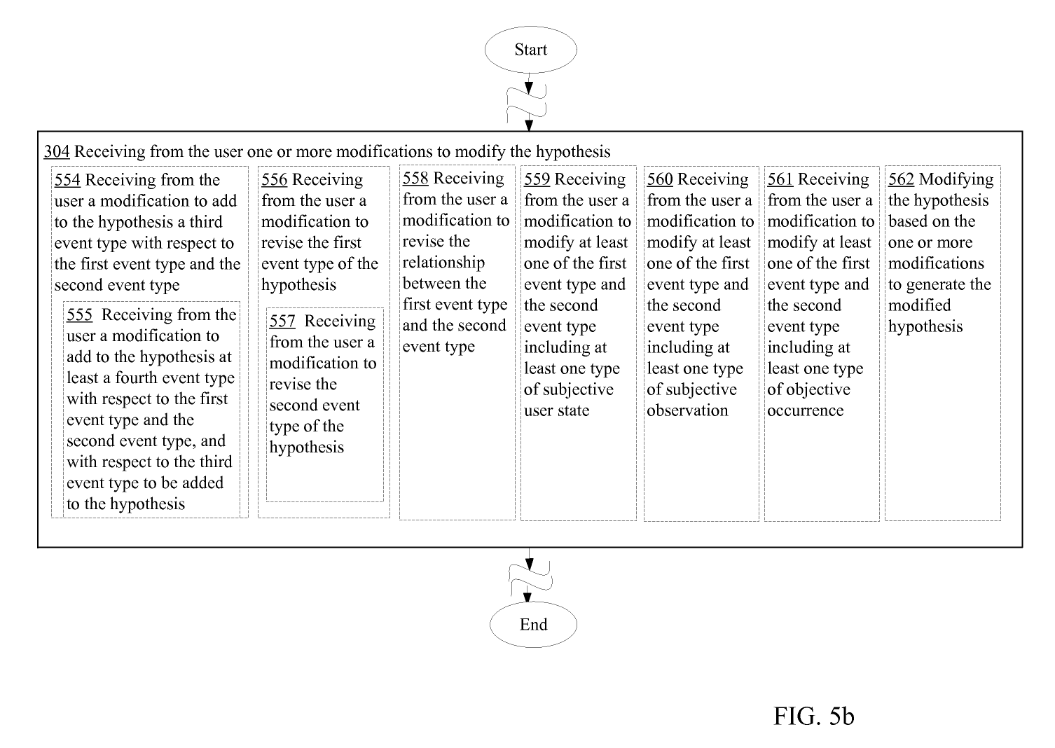

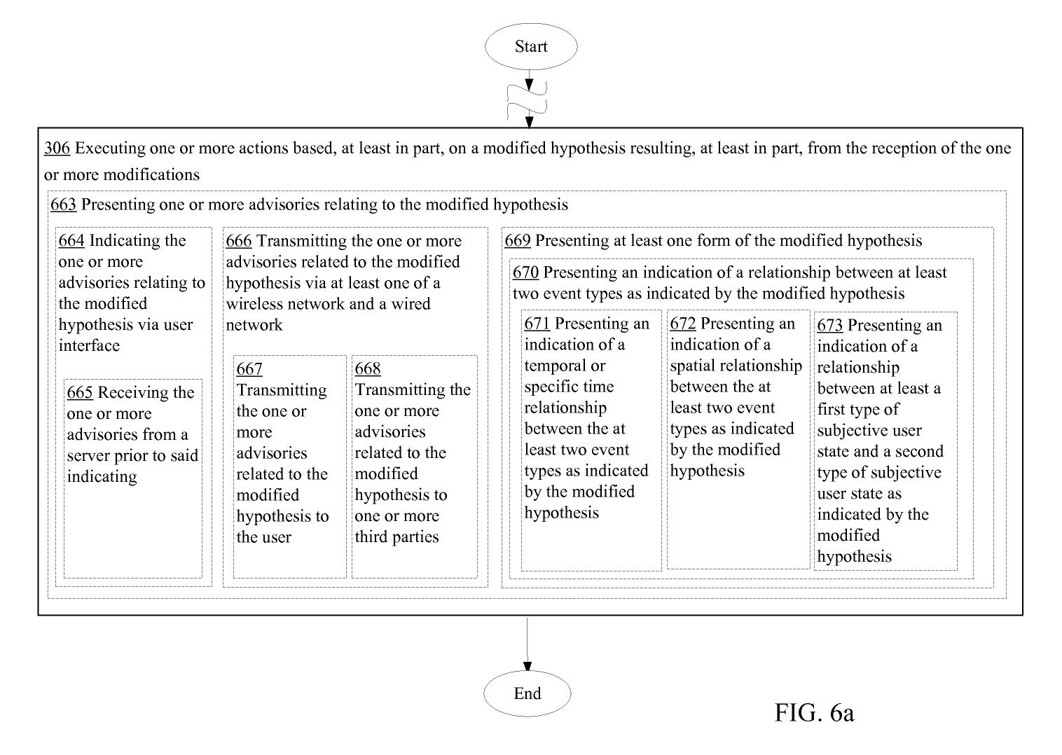

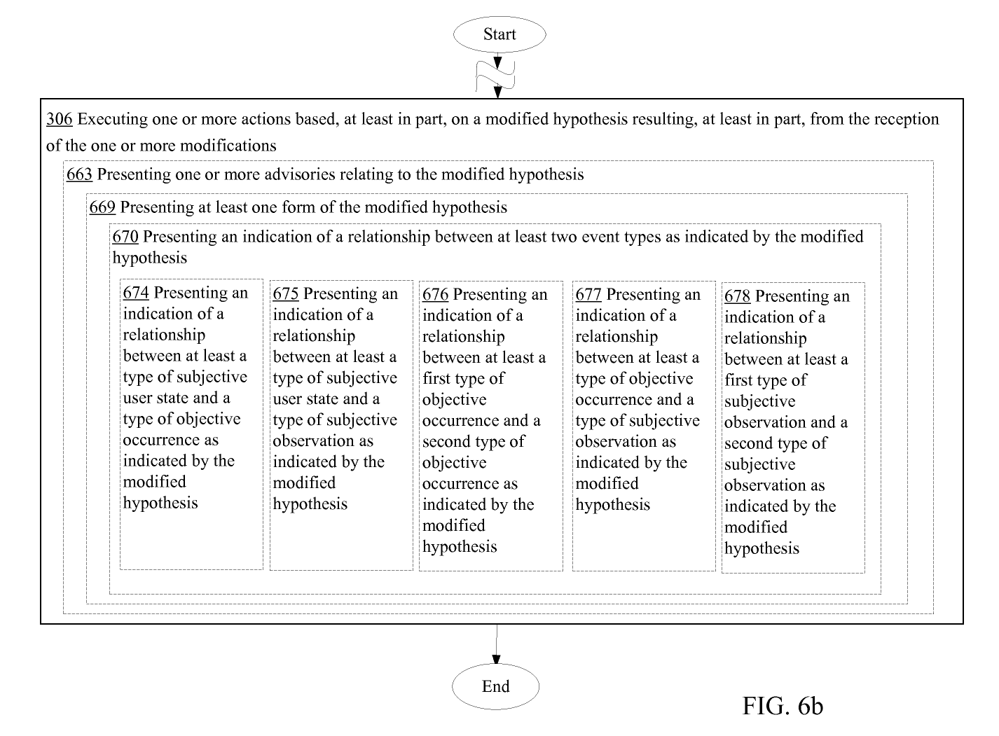

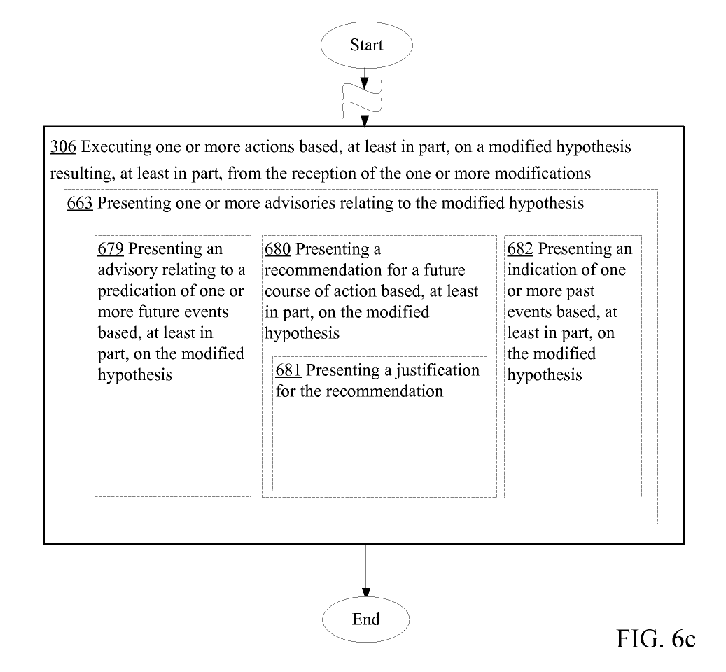

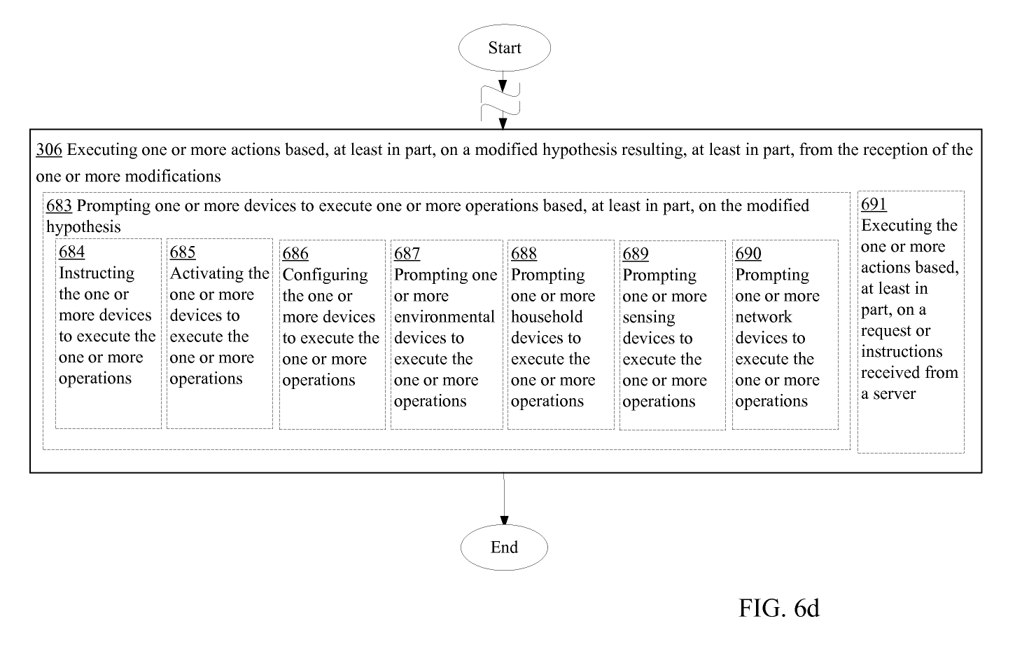

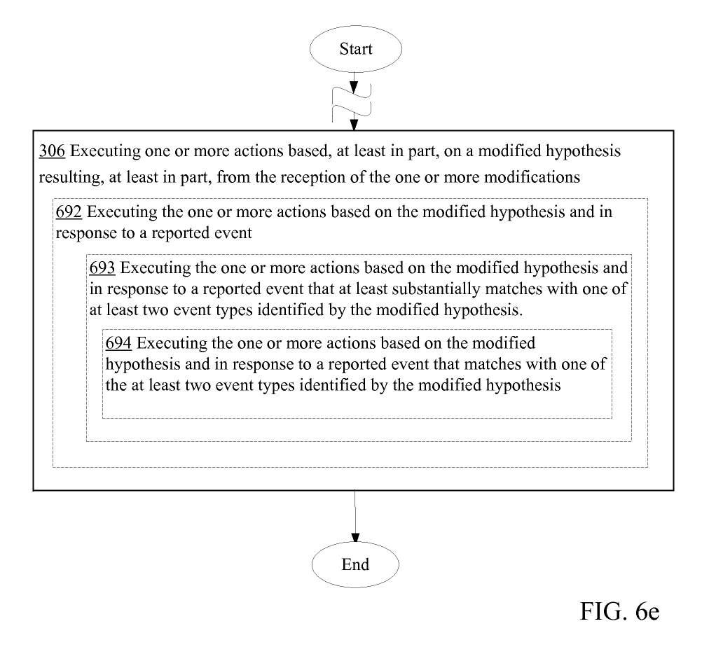

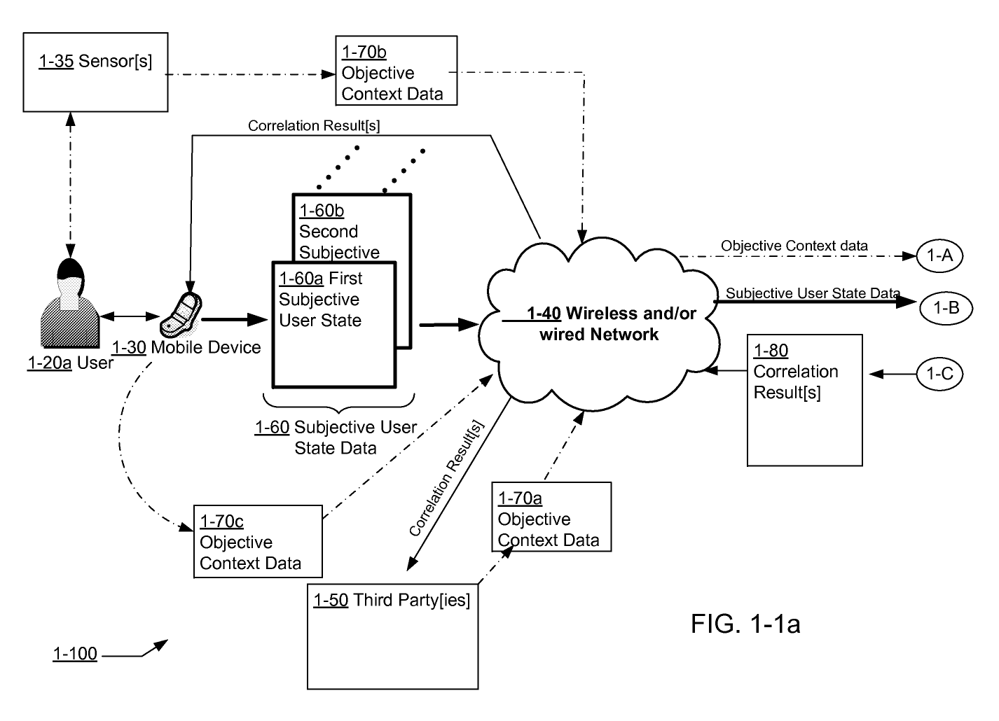

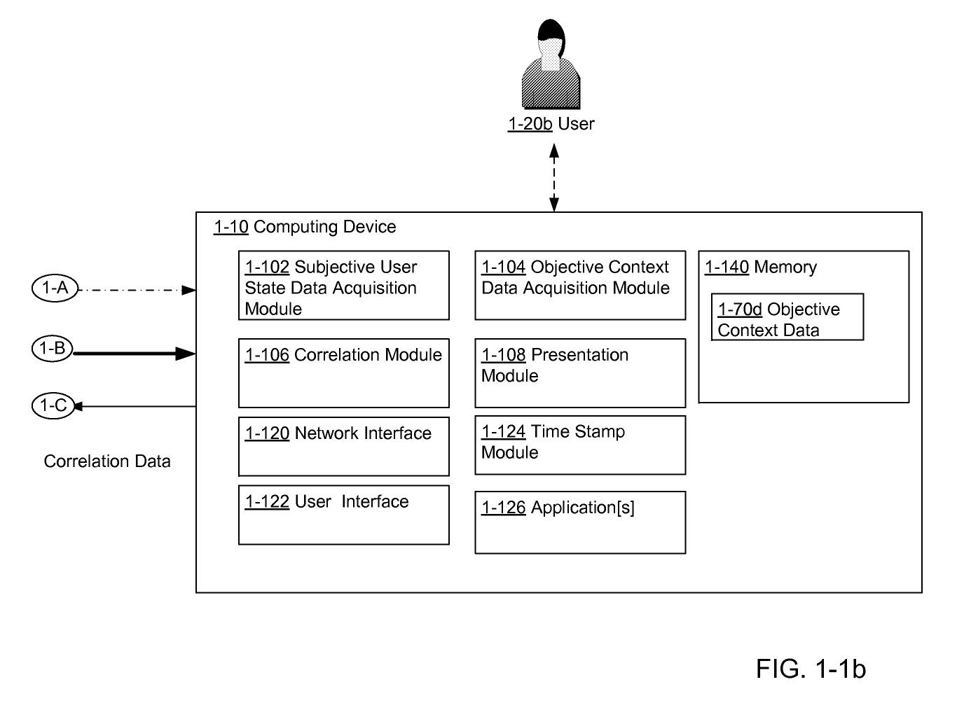

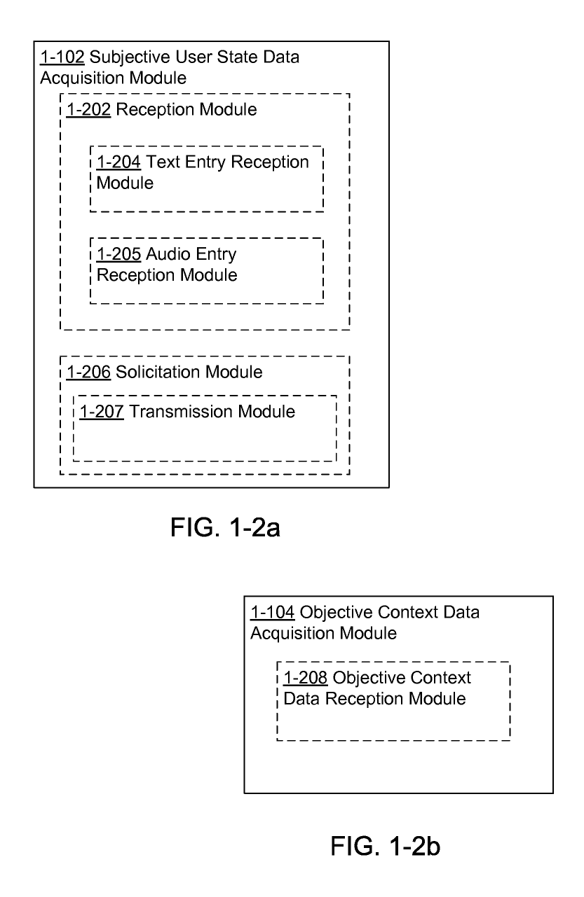

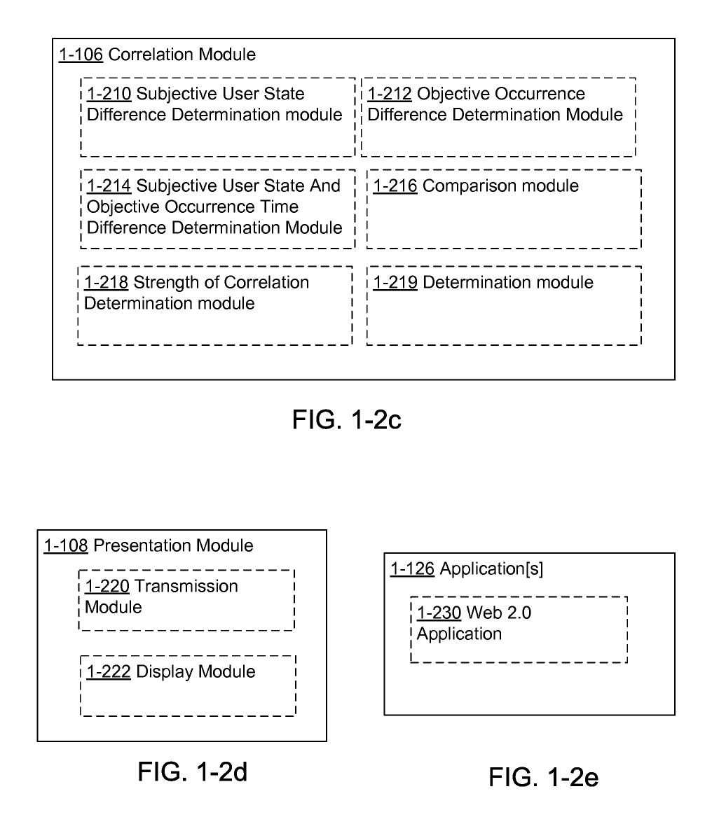

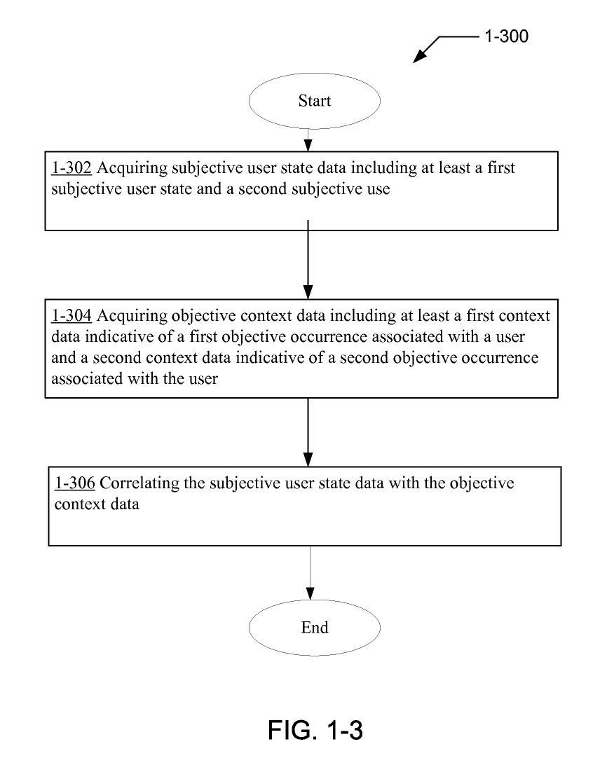

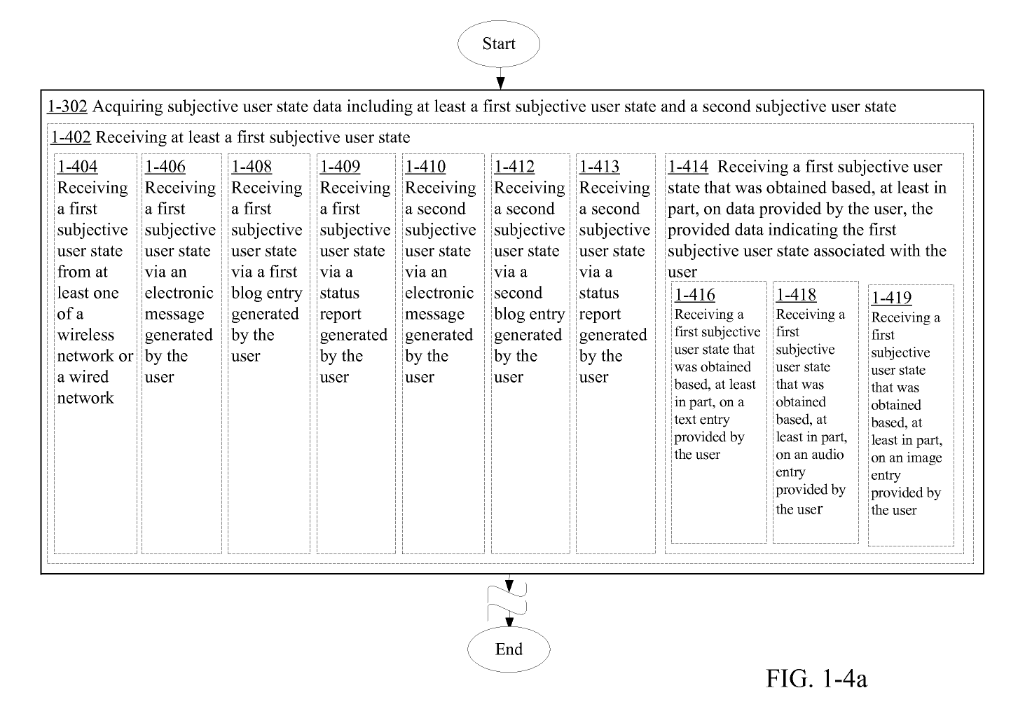

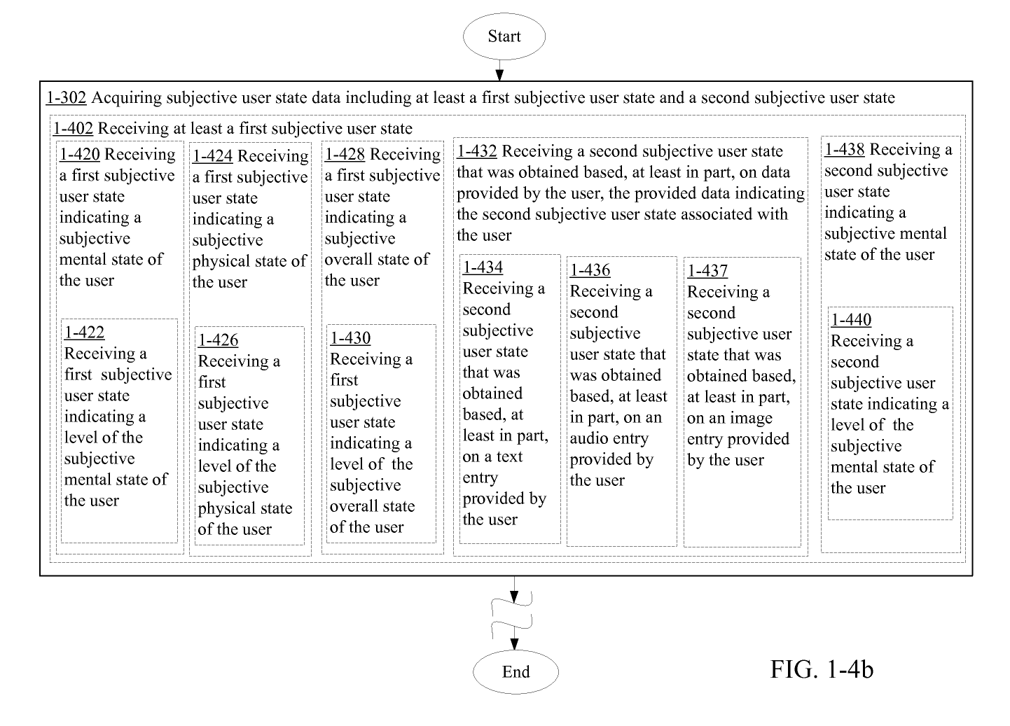

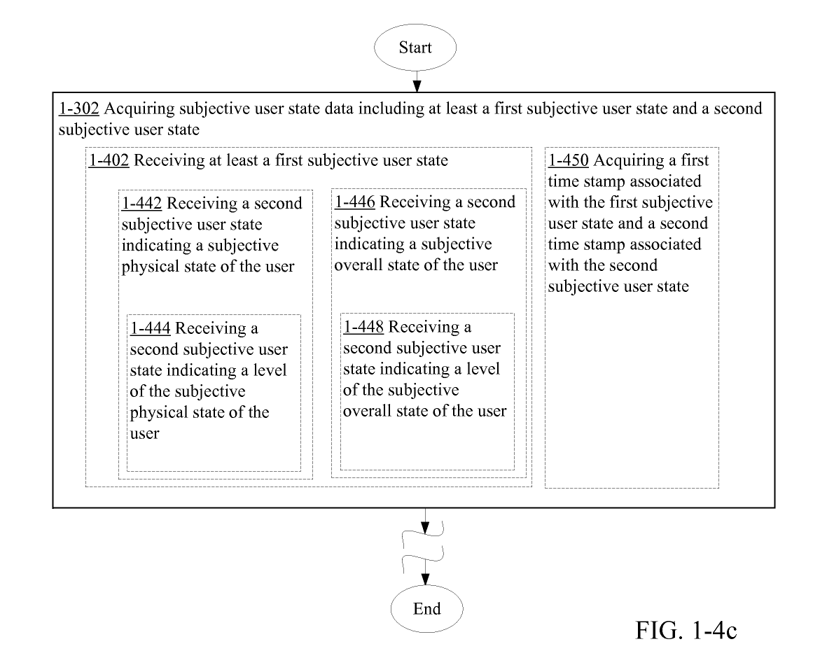

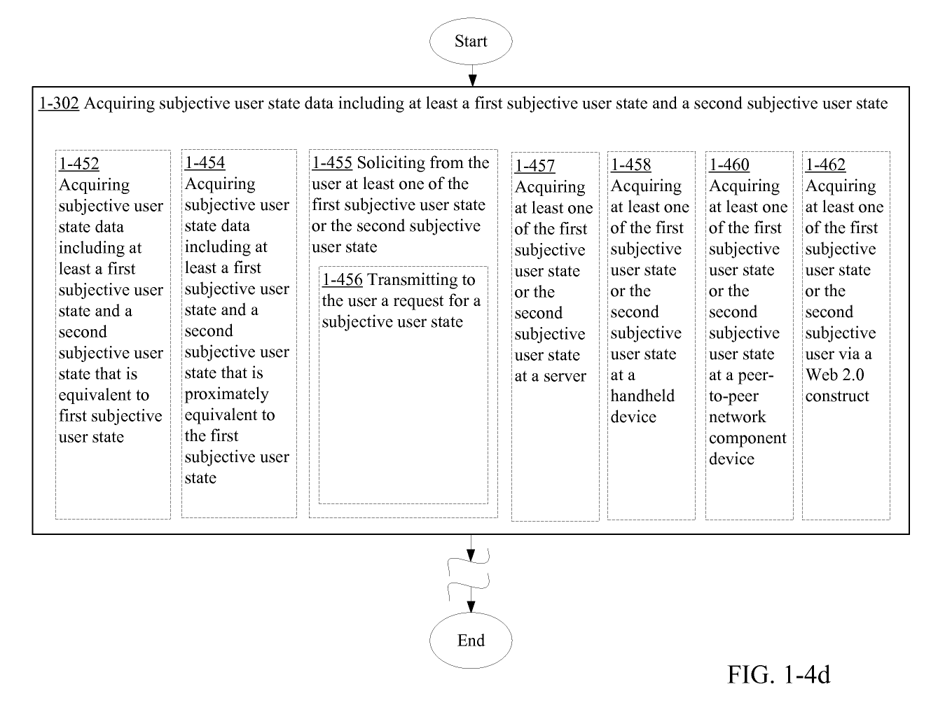

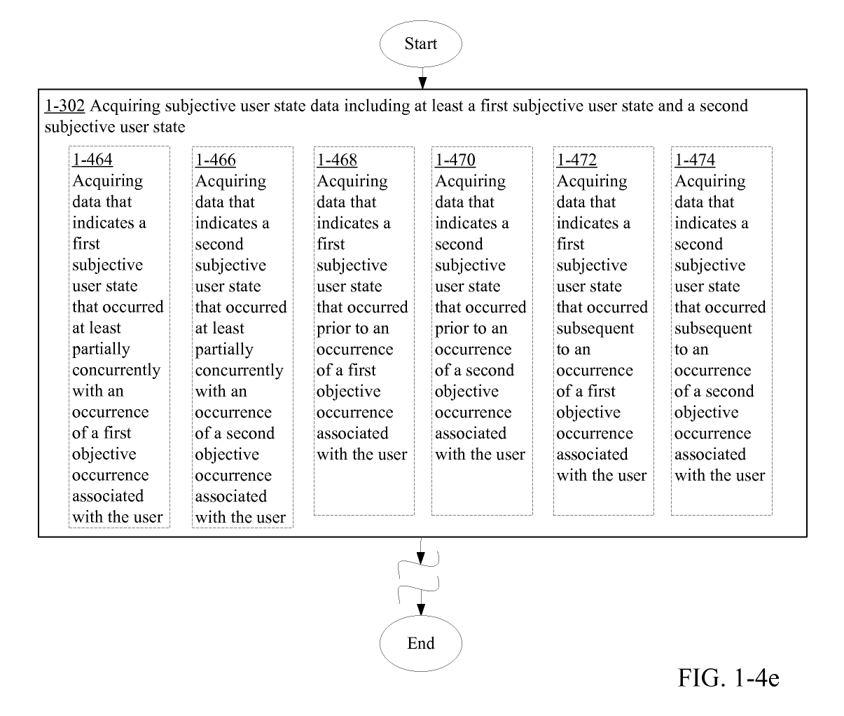

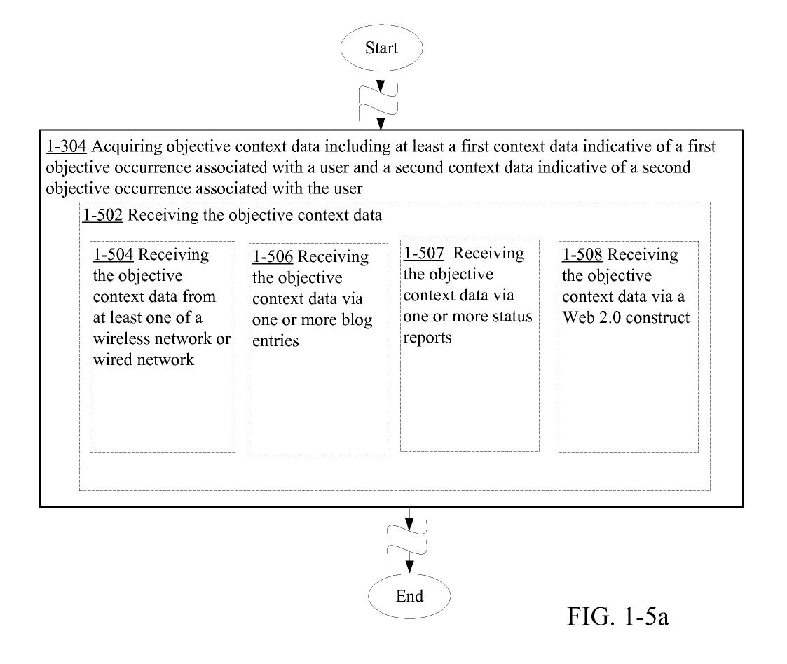

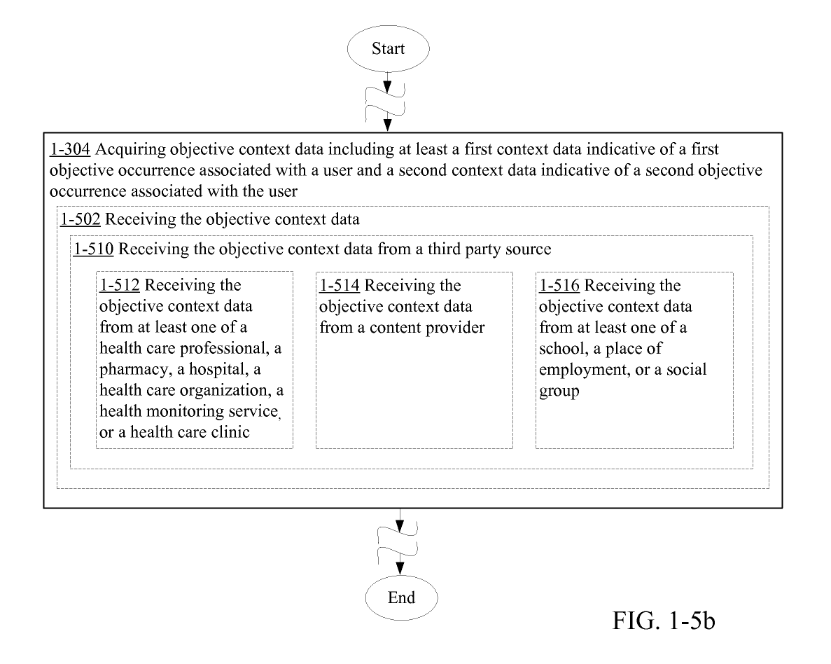

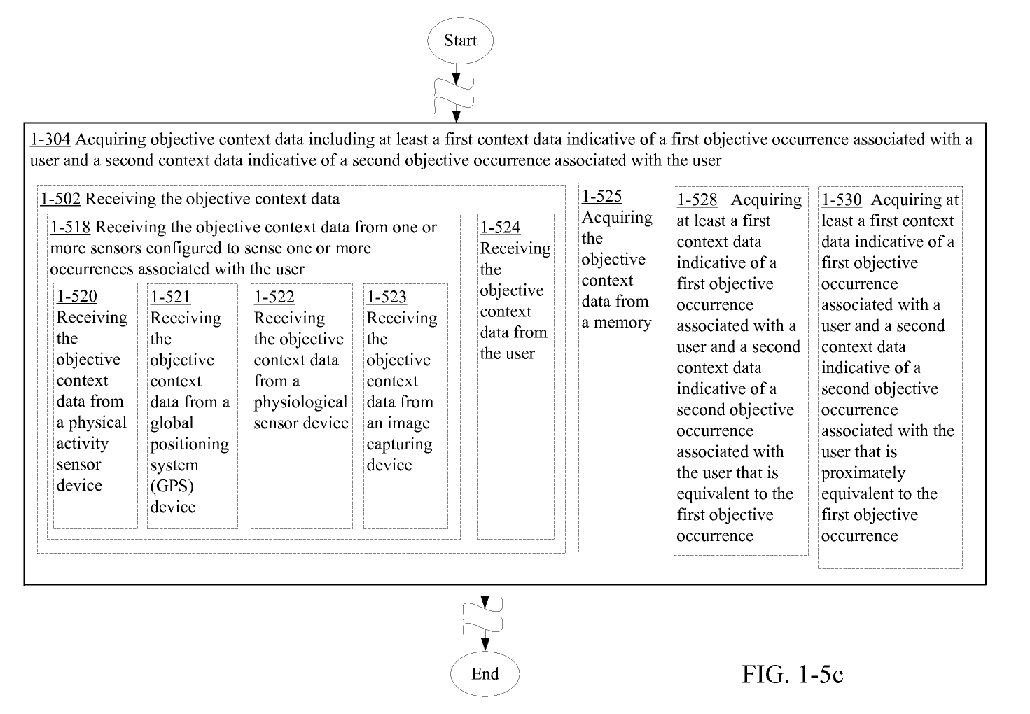

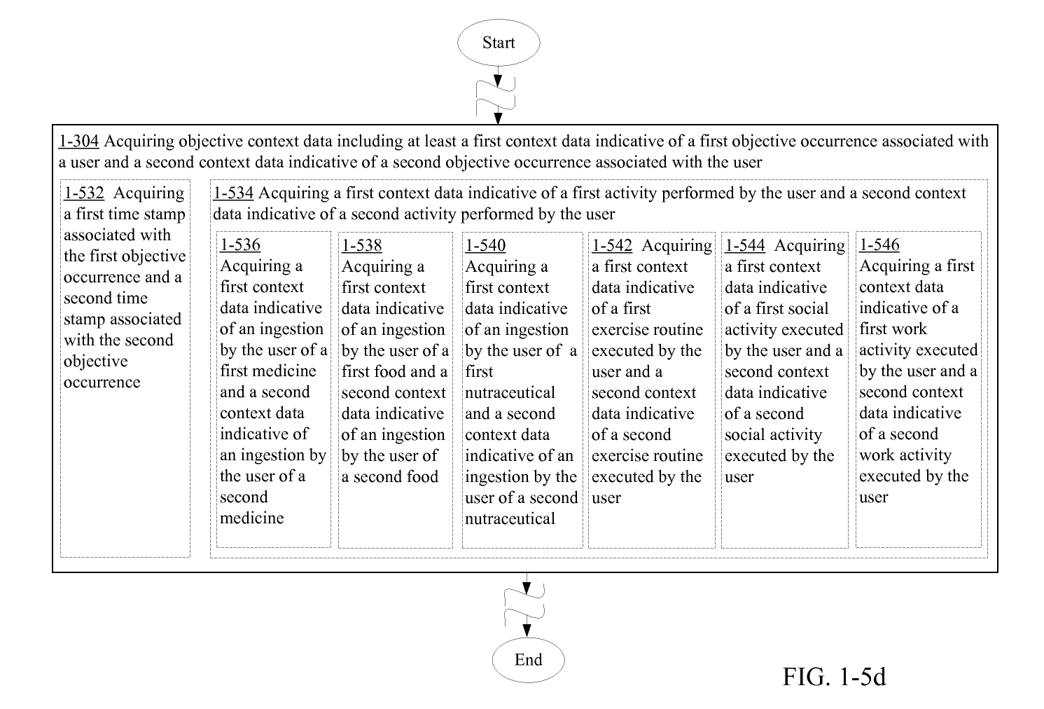

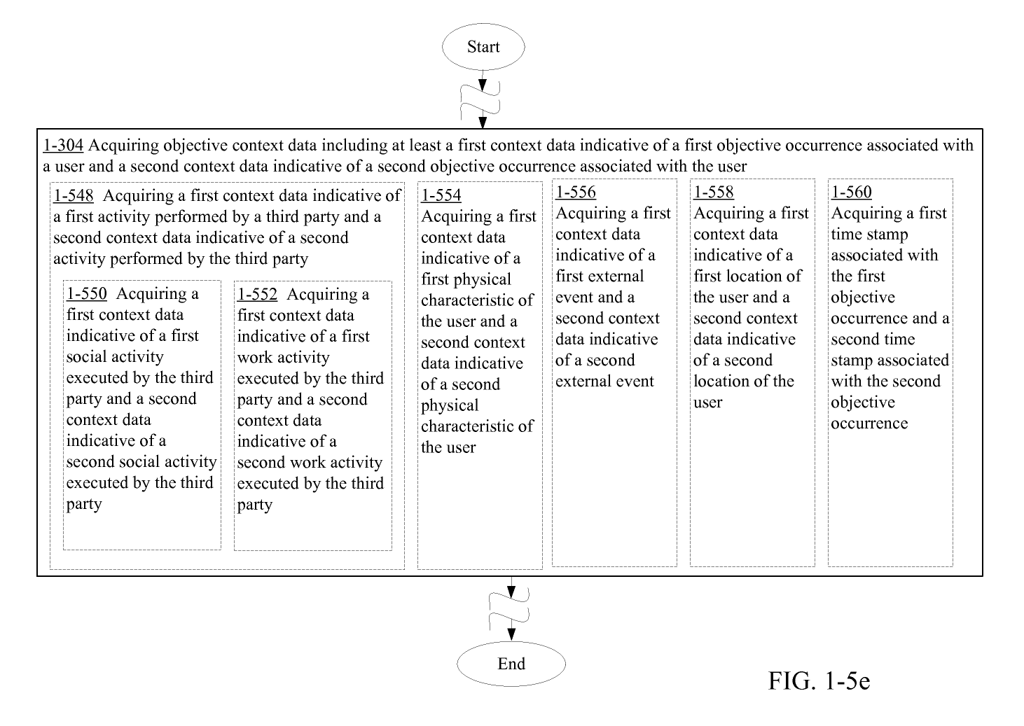

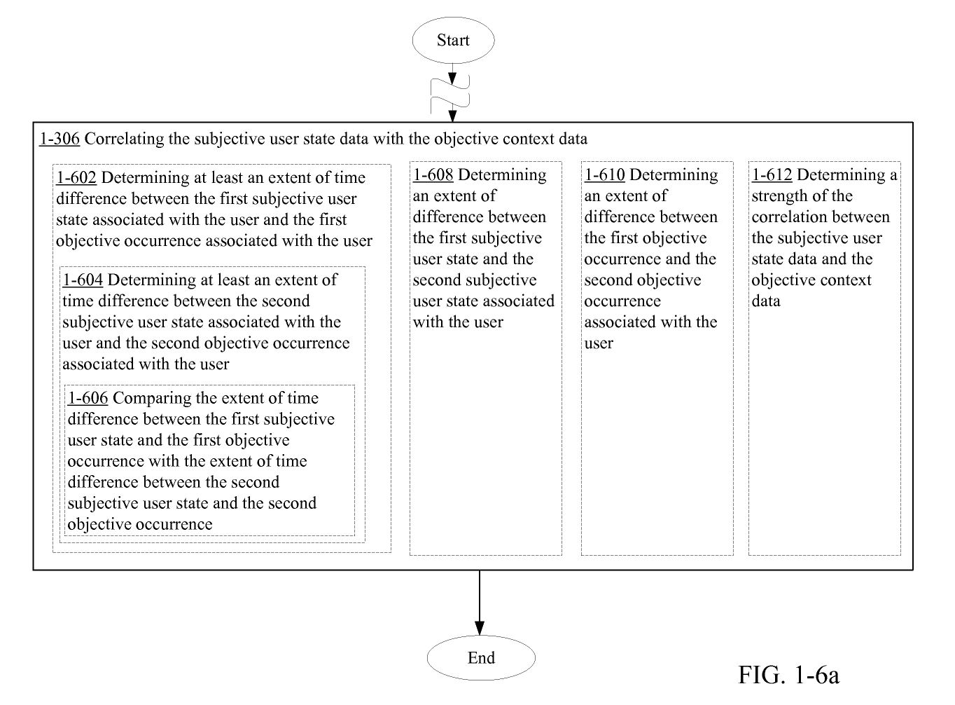

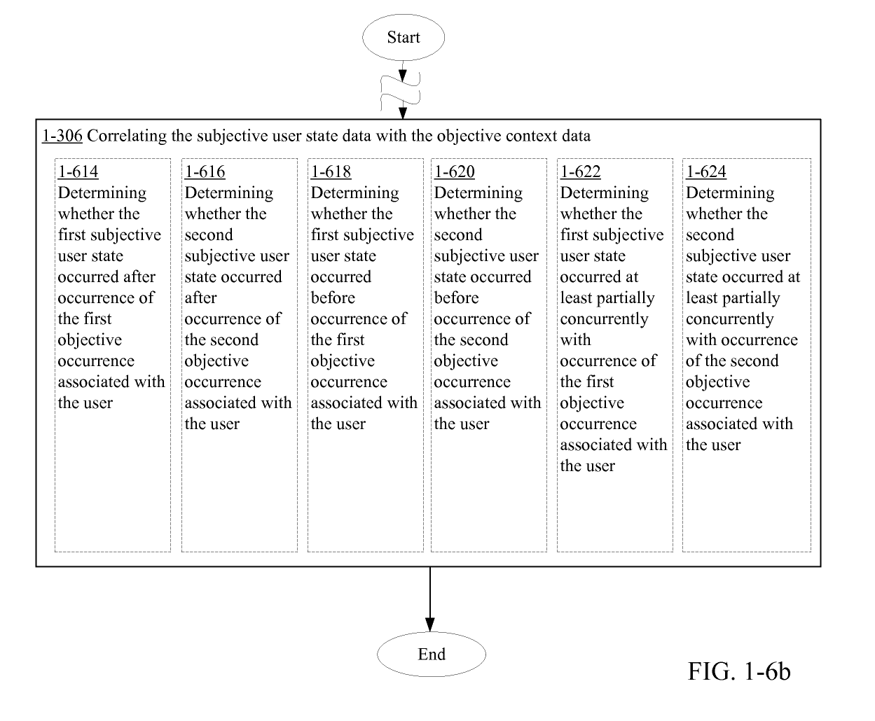

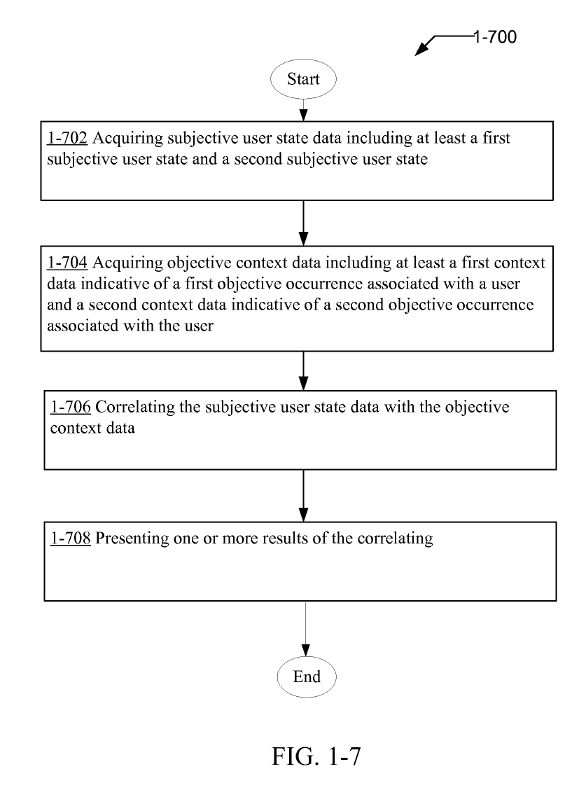

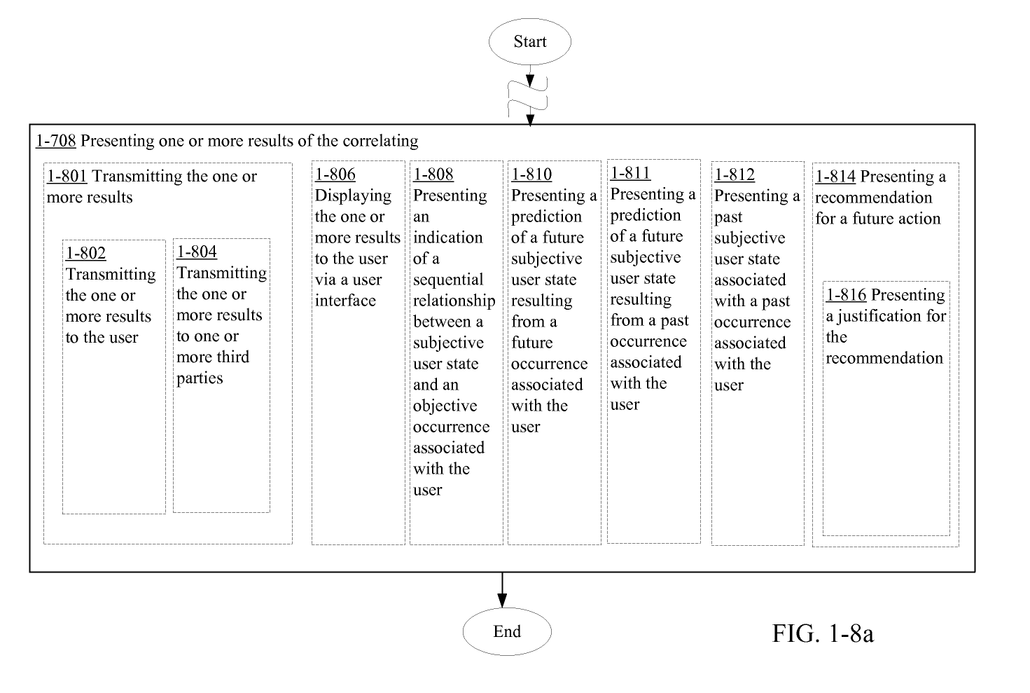

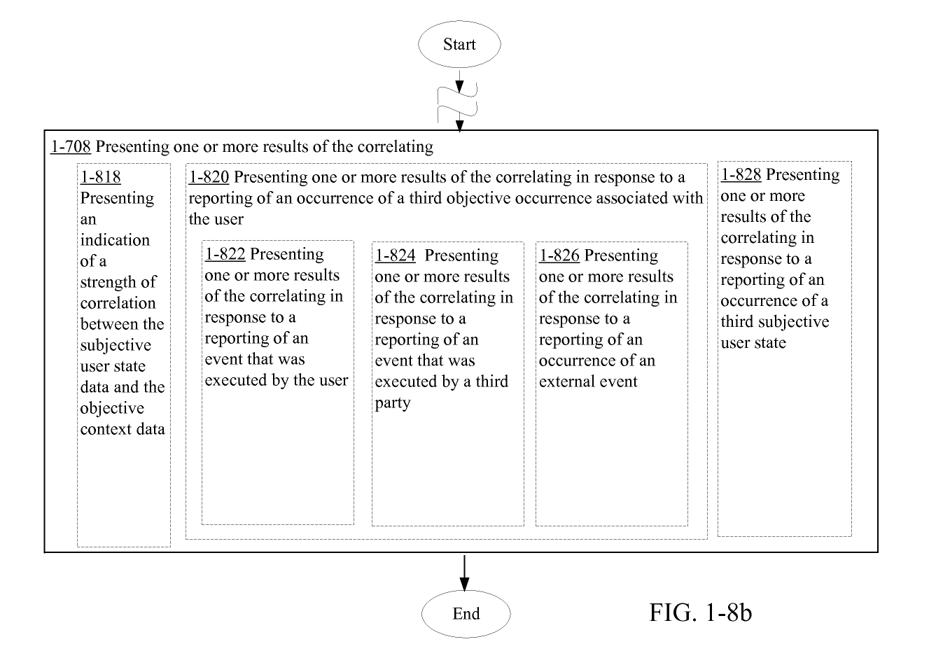

FIGS. 1-1a and 1-1b show a high-level block diagram of a network device operating in a network environment.

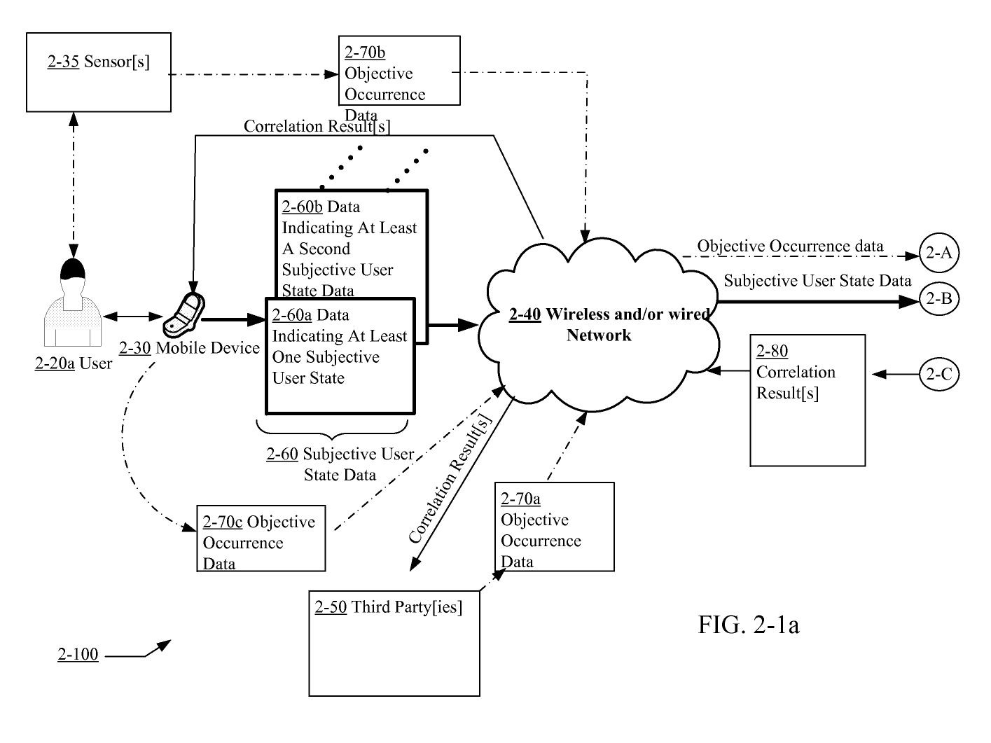

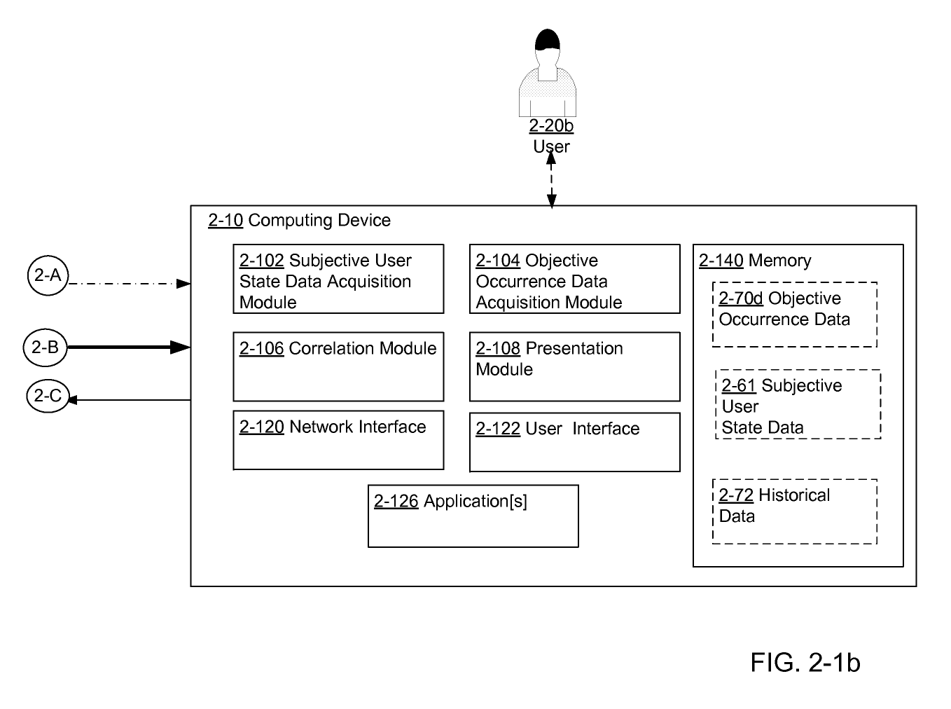

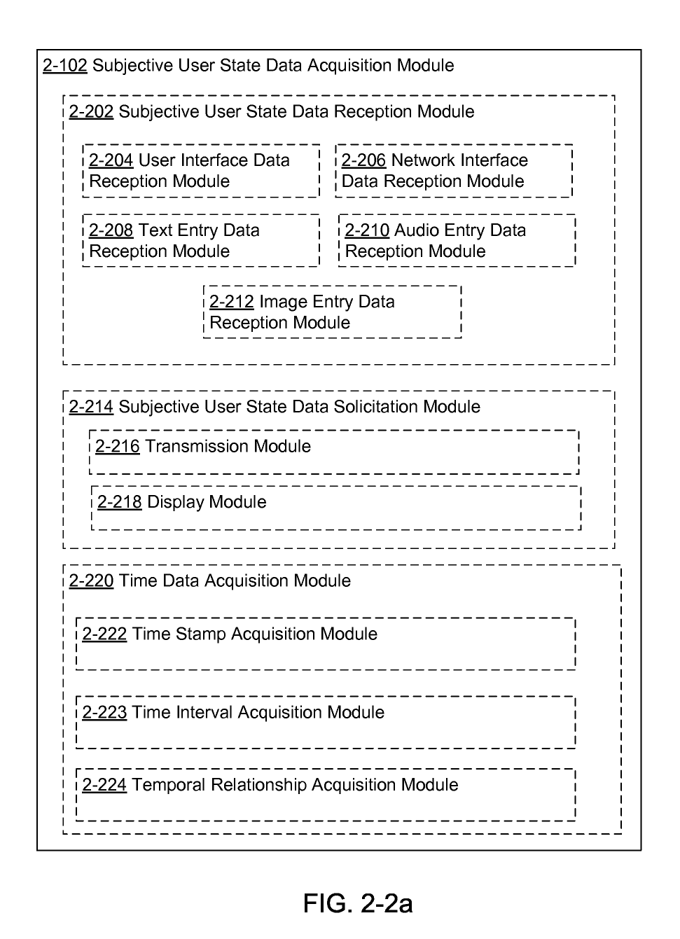

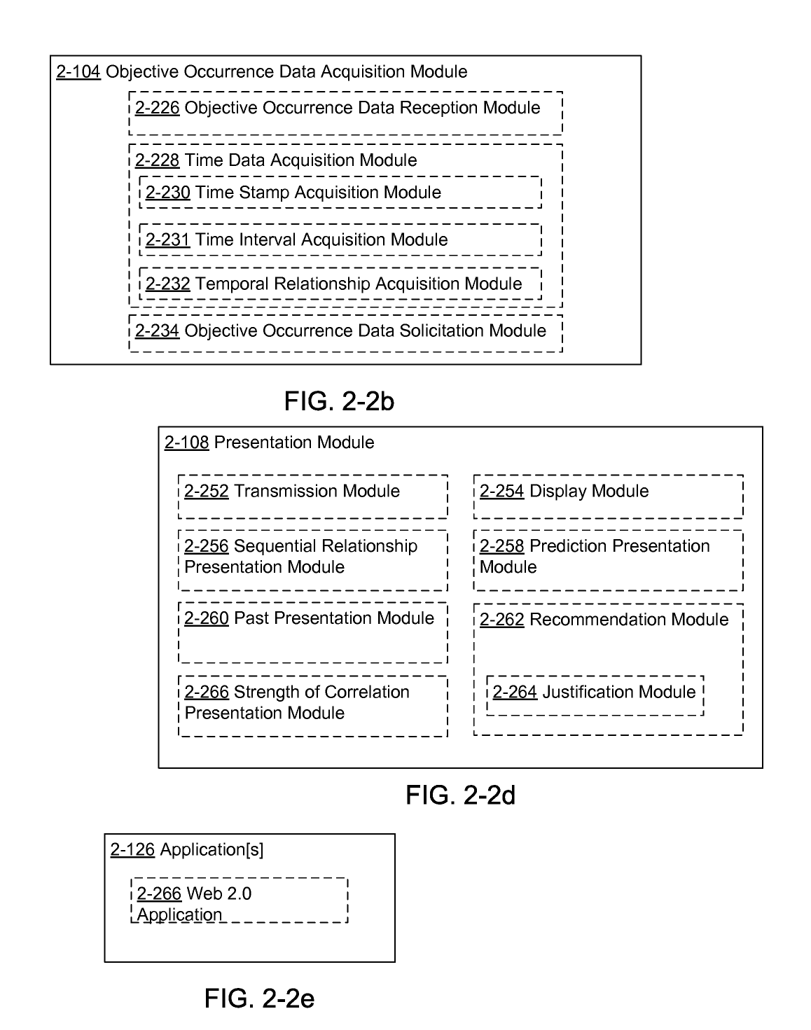

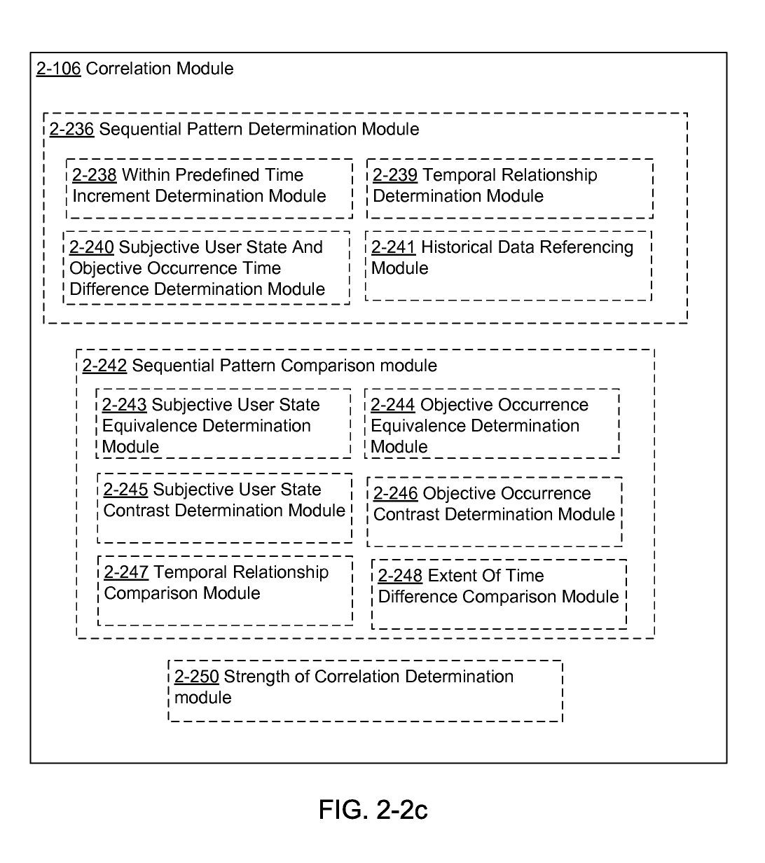

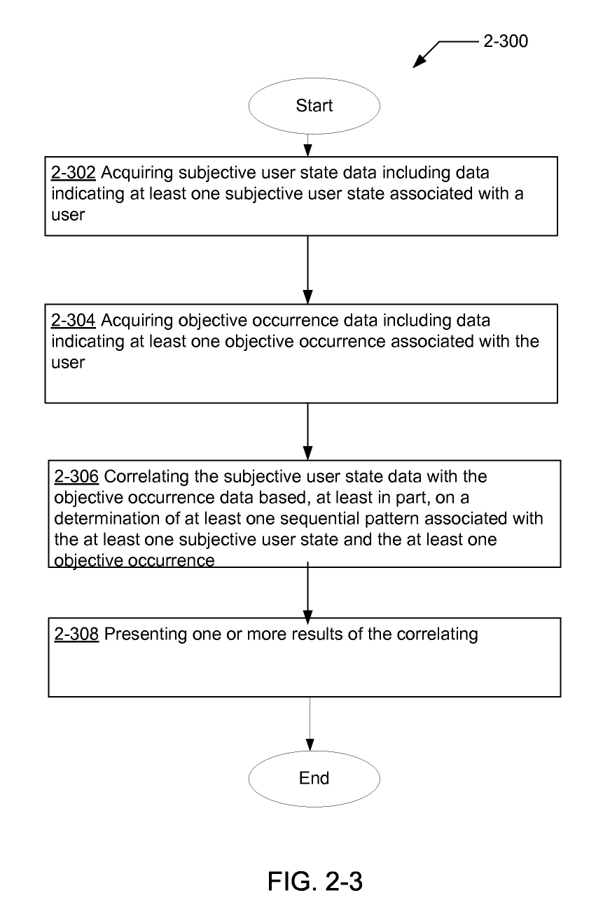

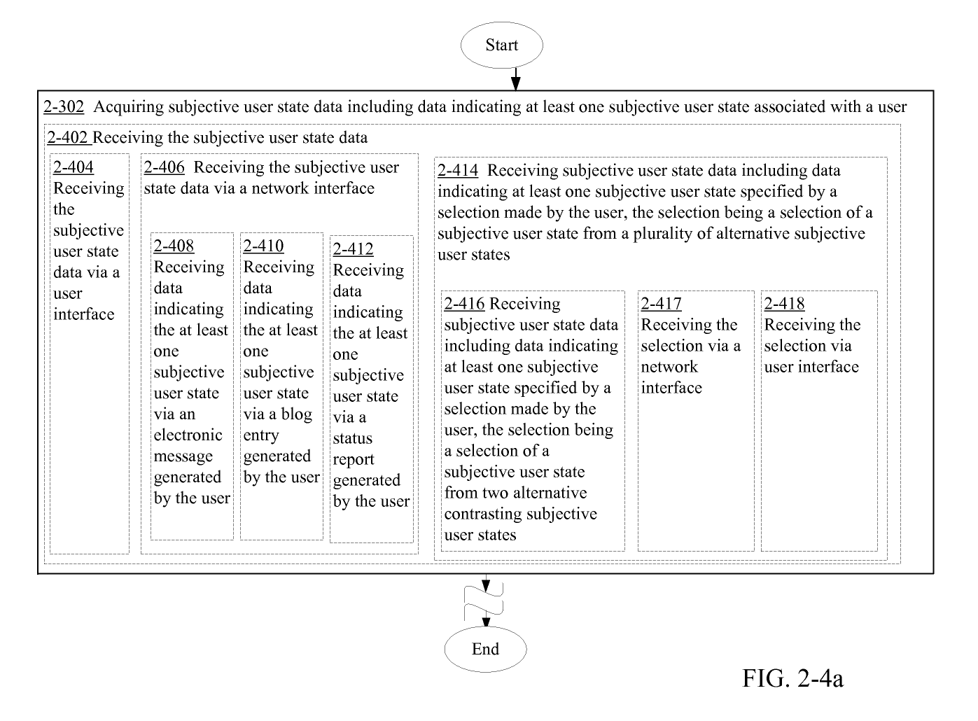

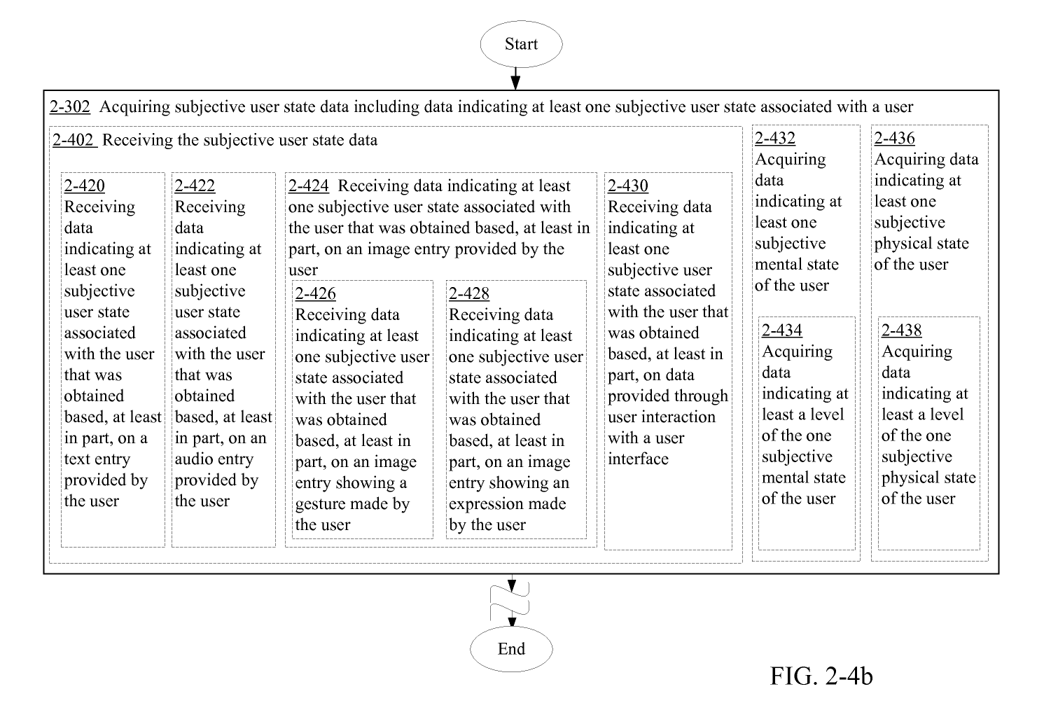

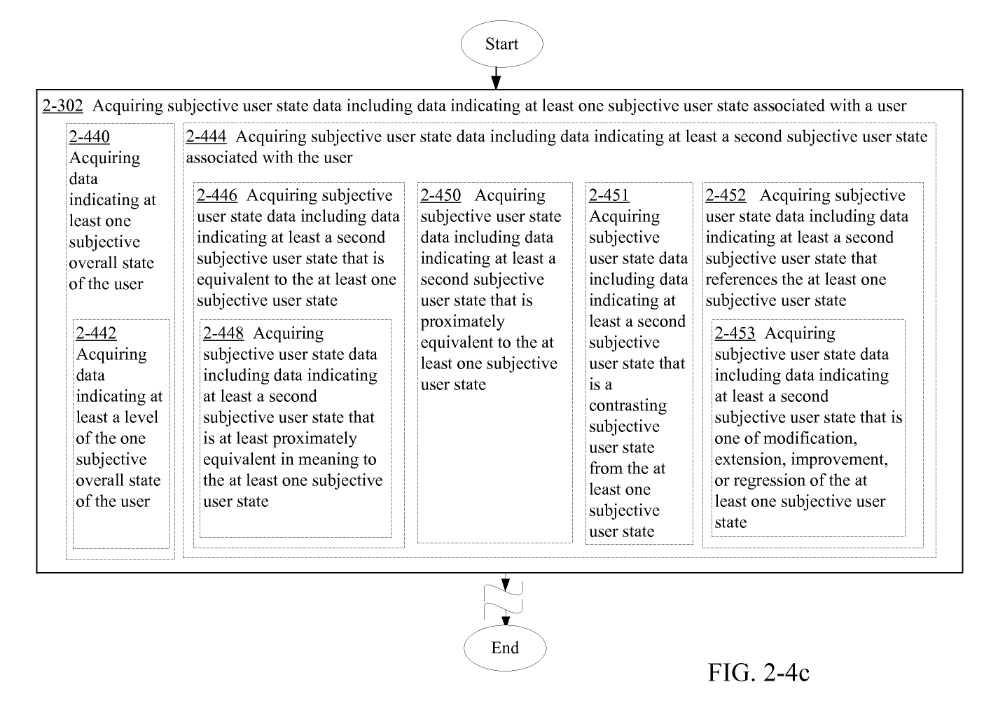

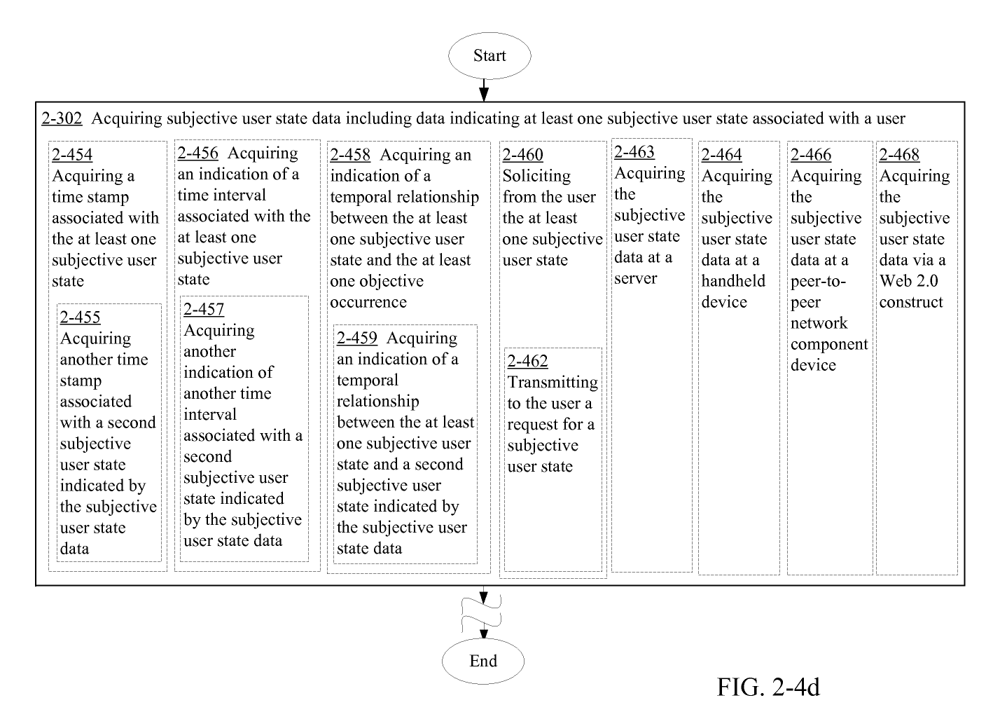

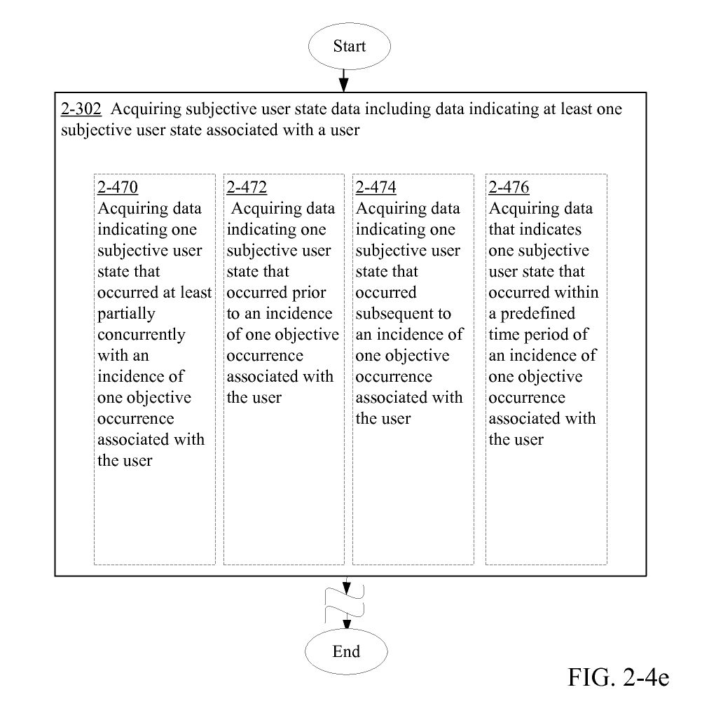

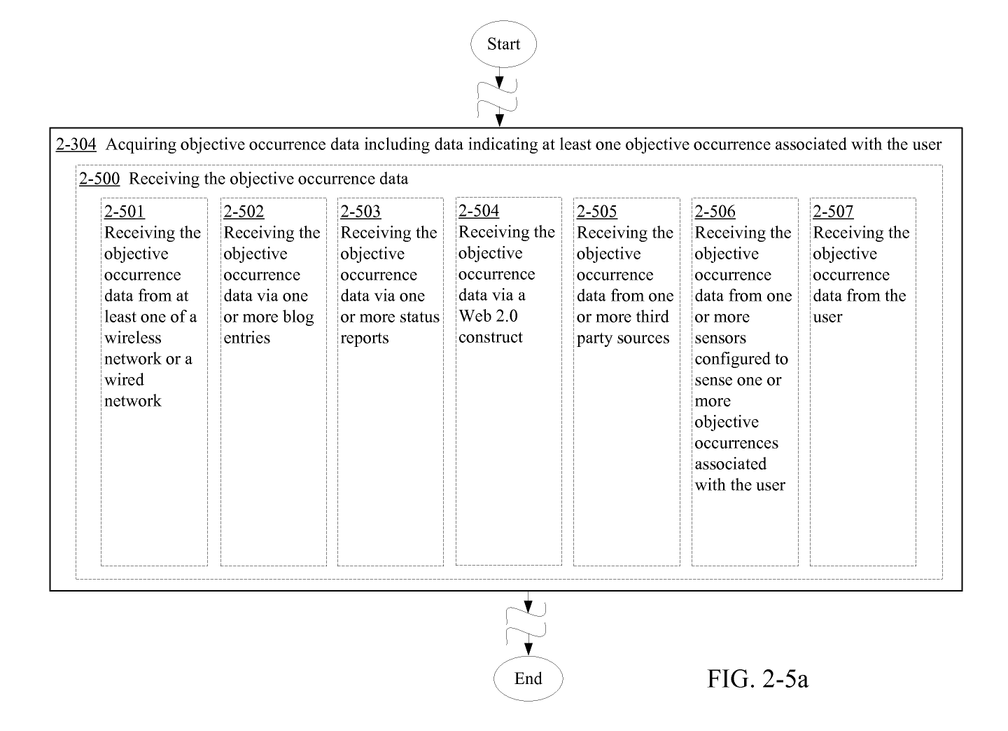

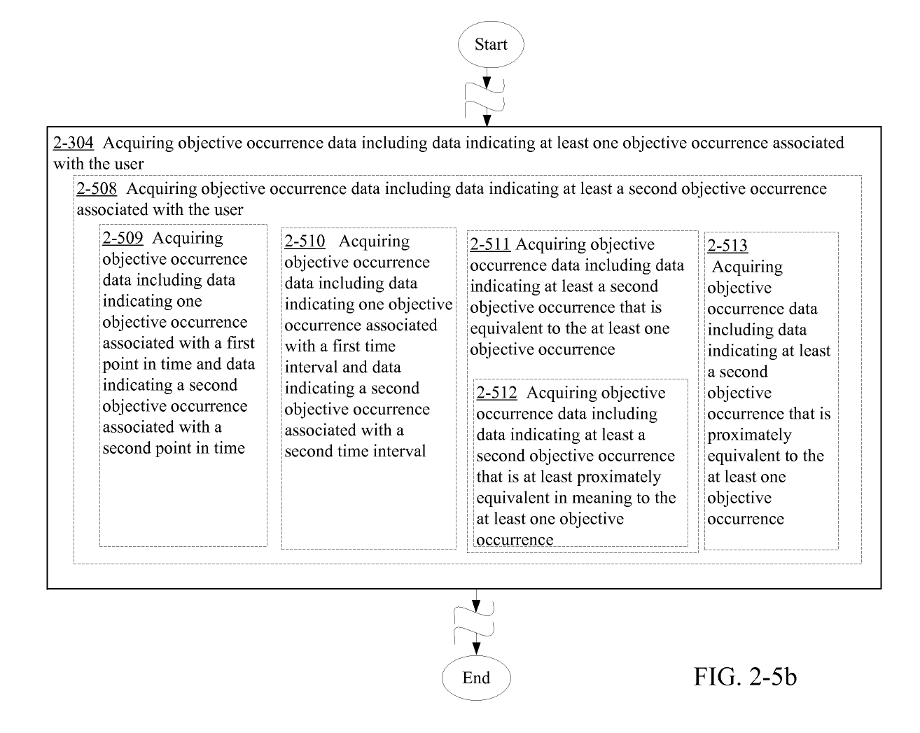

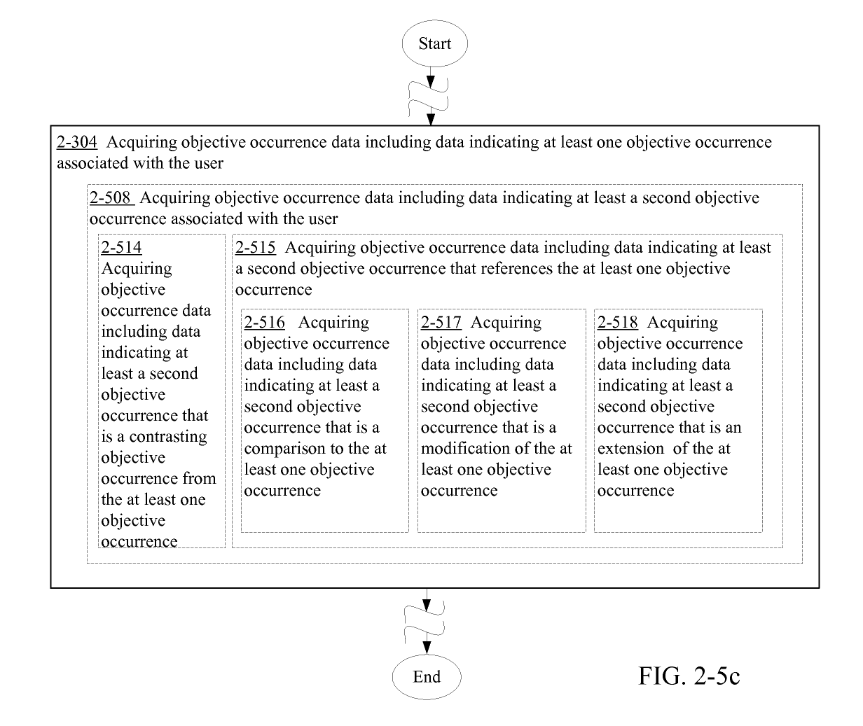

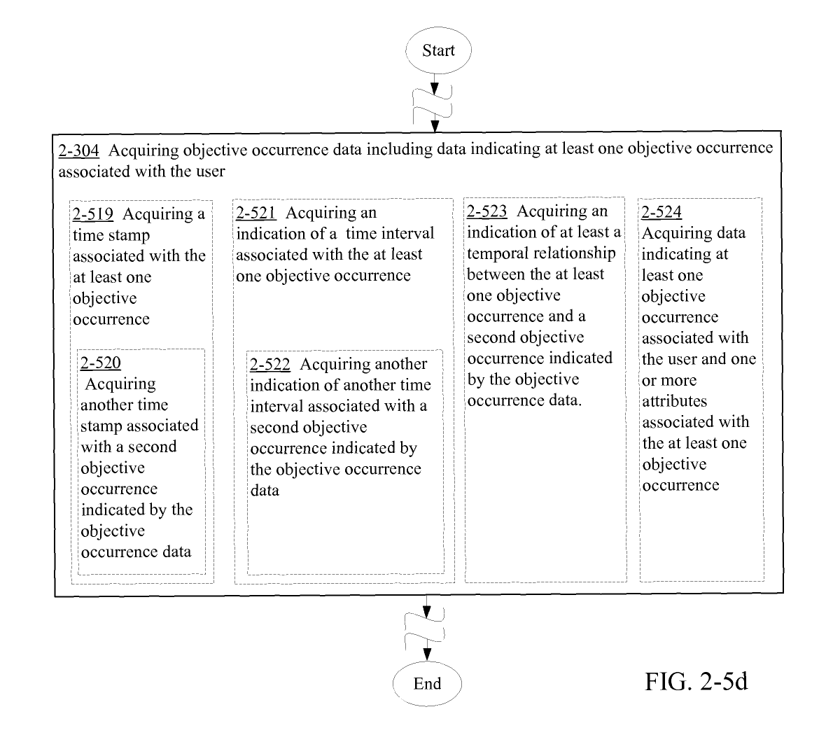

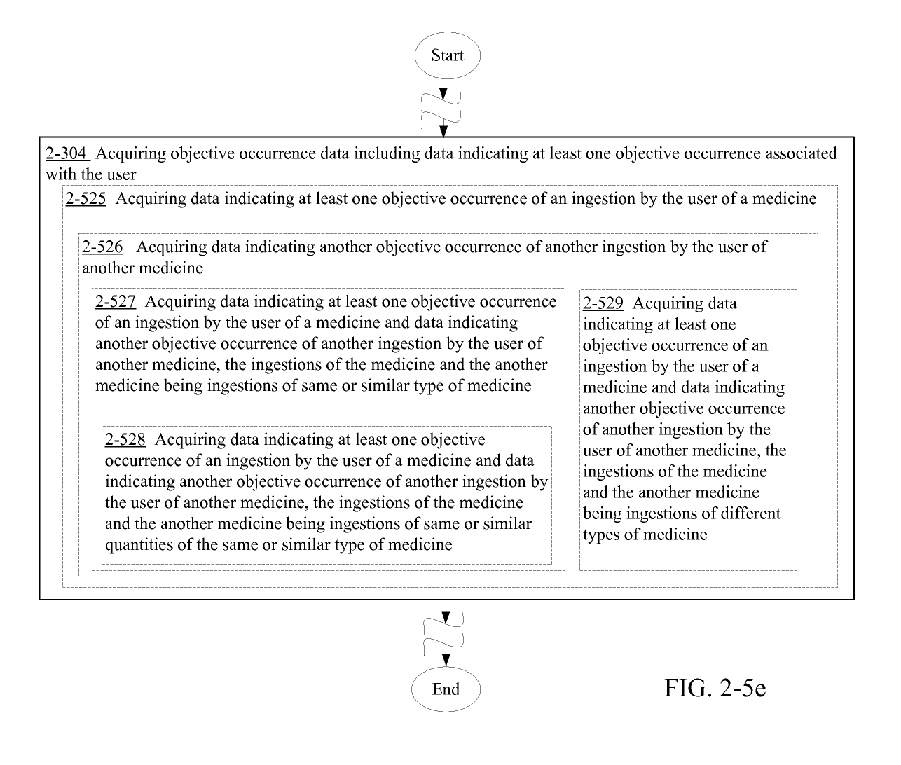

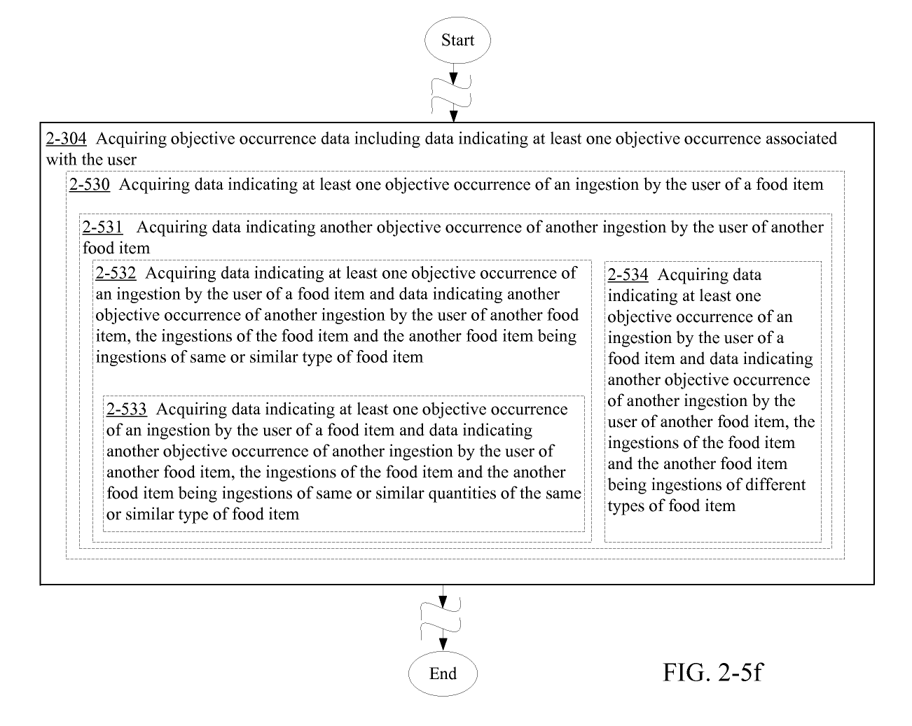

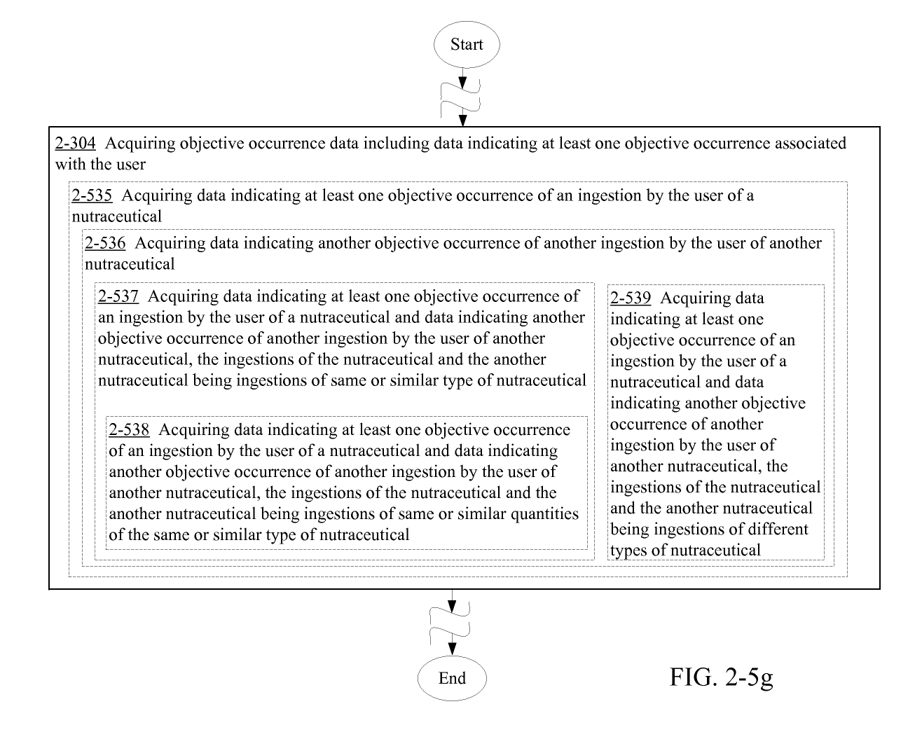

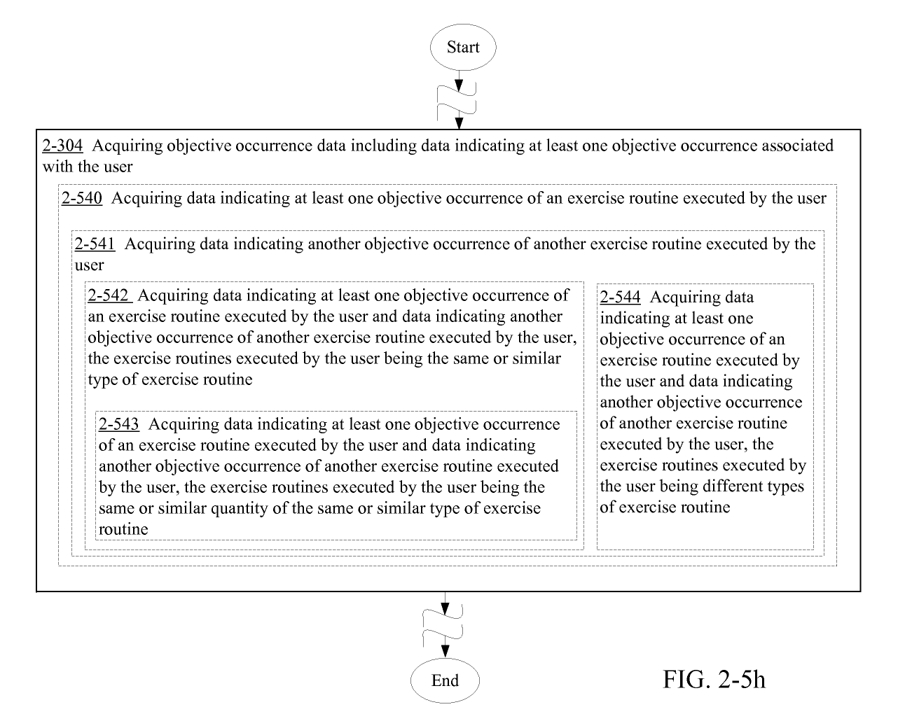

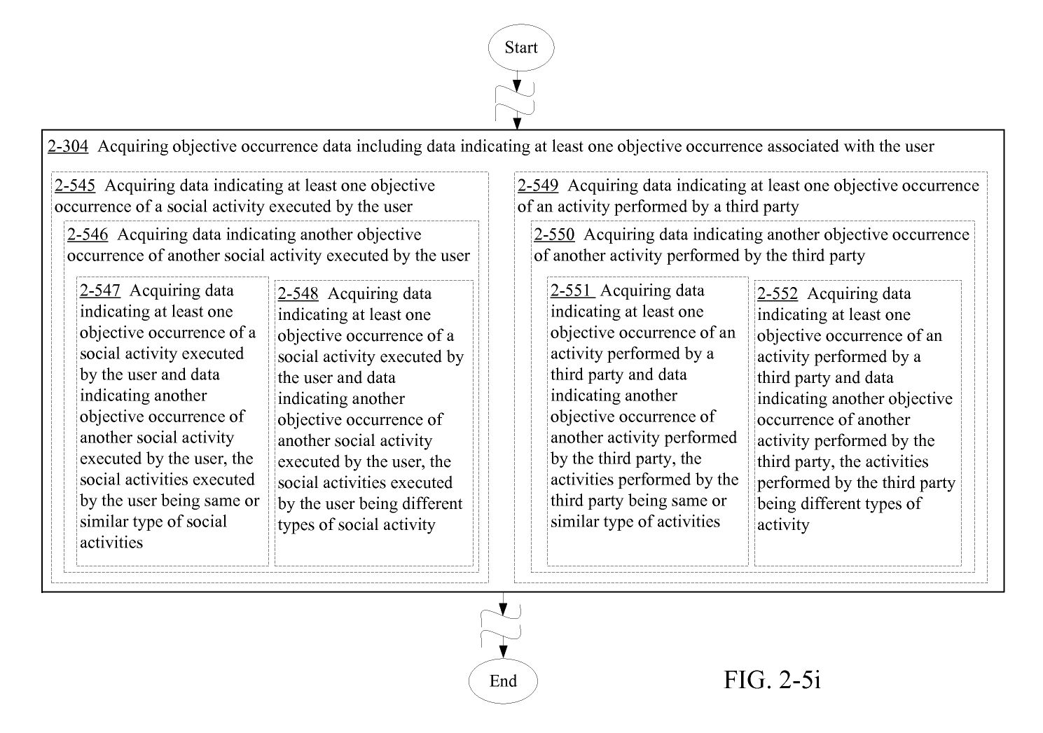

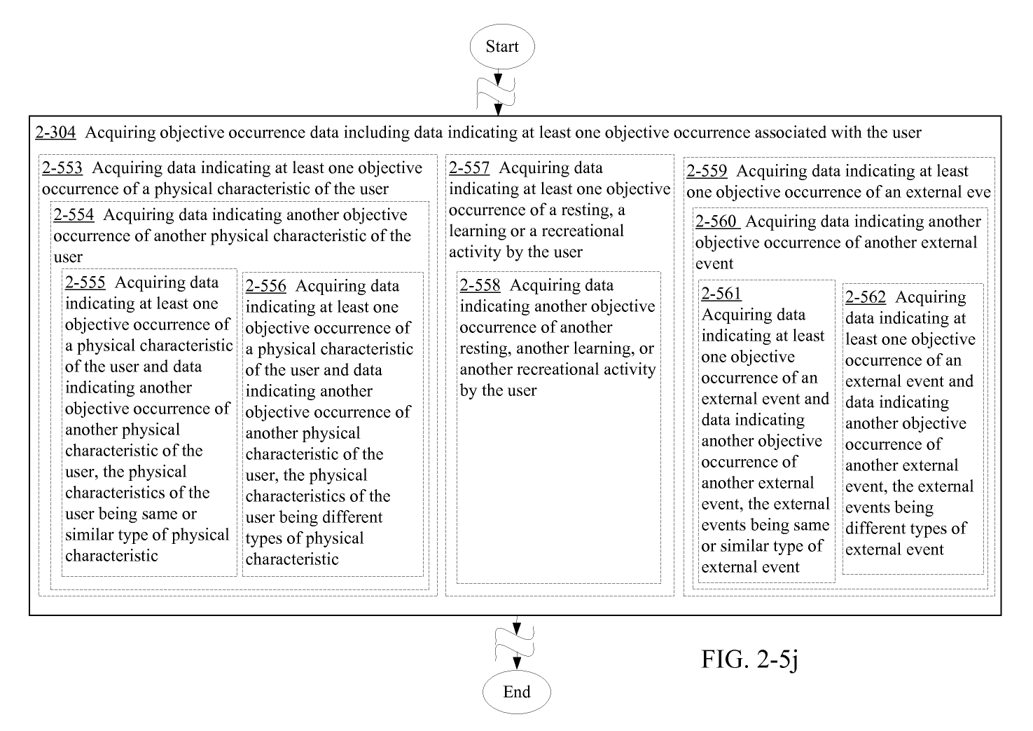

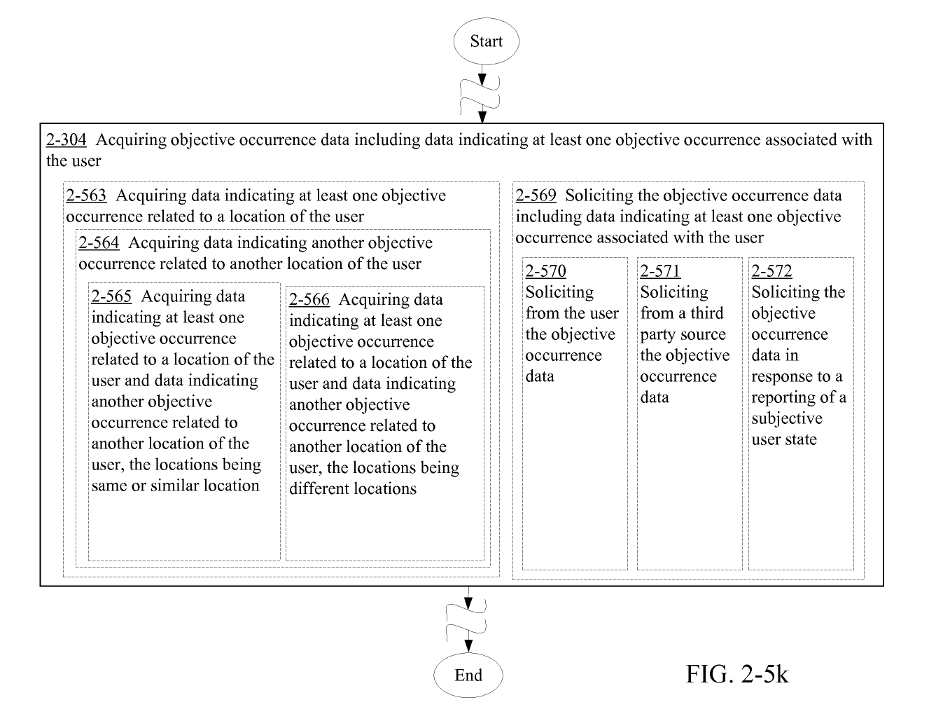

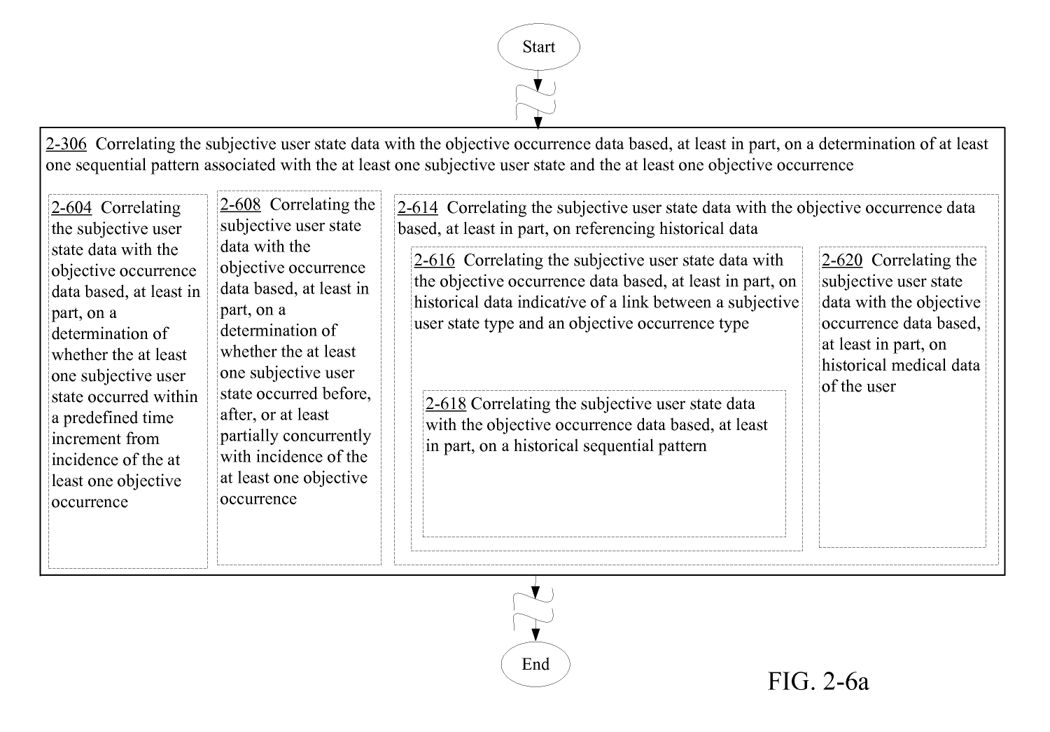

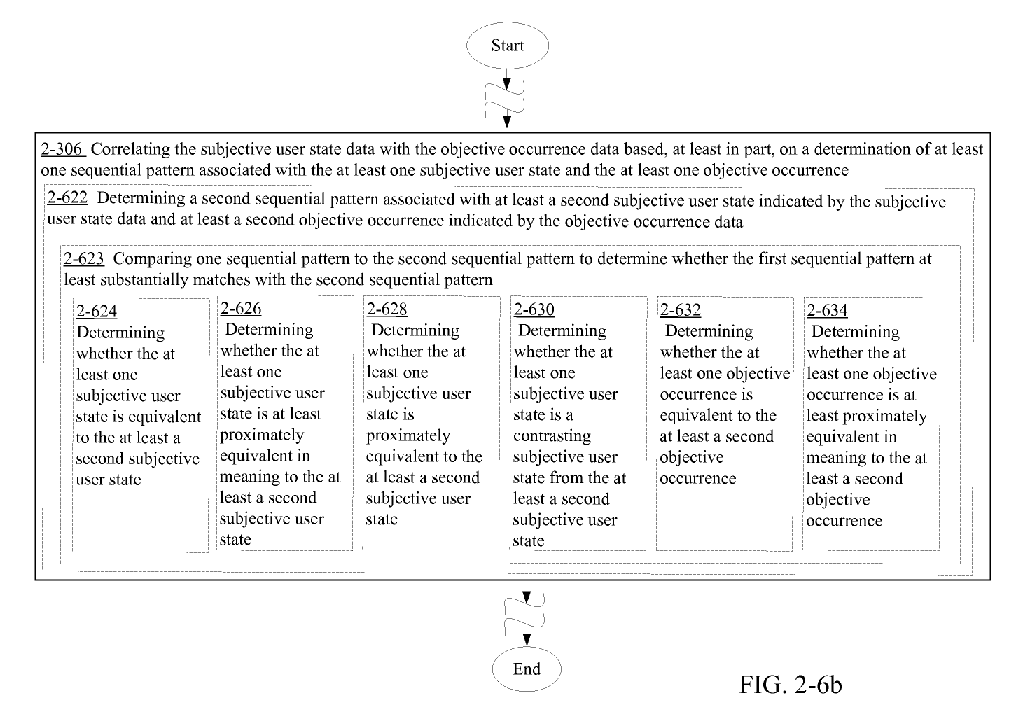

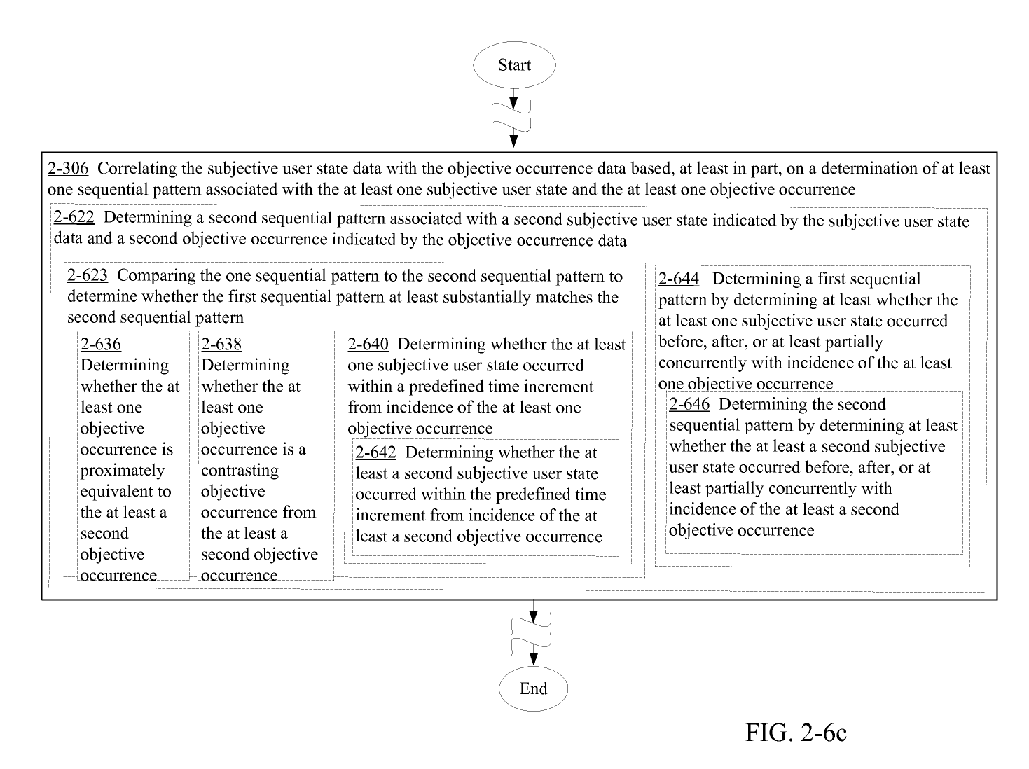

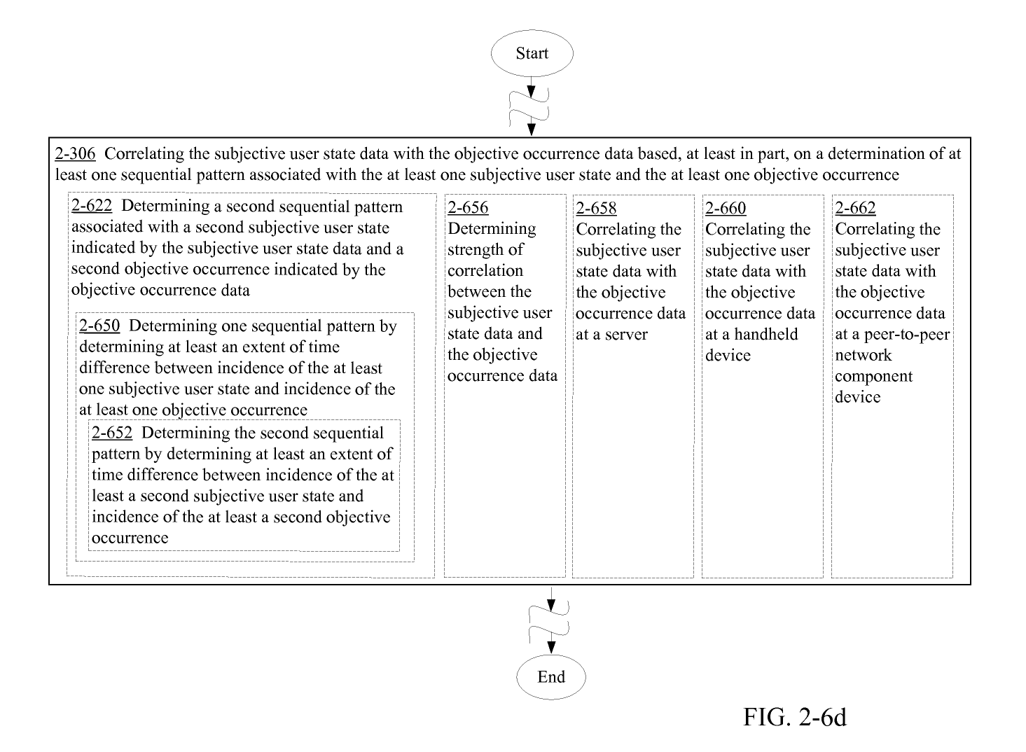

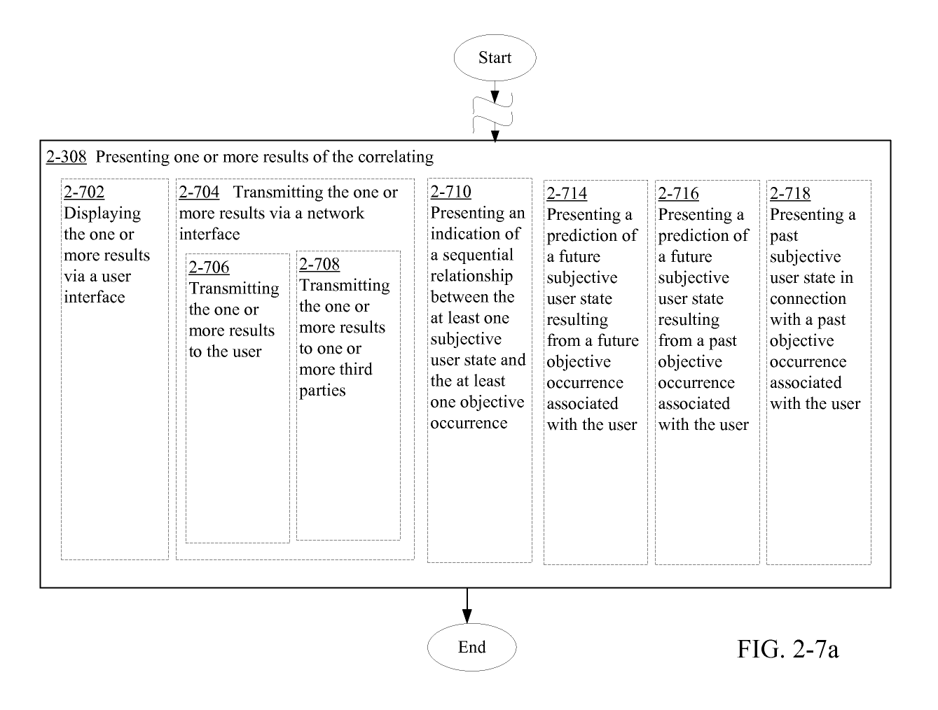

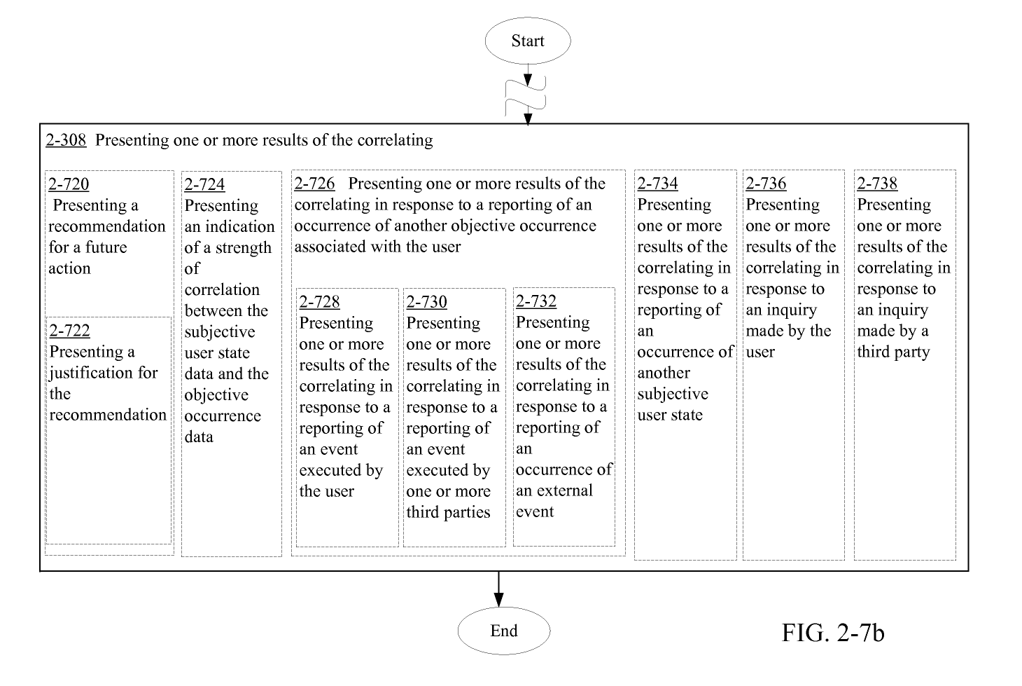

FIG. 1-2a shows another perspective of the subjective user state data acquisition module 1-102 of the computing device 1-10 of FIG. 1-1b.

FIG. 1-2b shows another perspective of the objective context data acquisition module 1-104 of the computing device 1-10 of FIG. 1-1b.

FIG. 1-2c shows another perspective of the correlation module 1-106 of the computing device 1-10 of FIG. 1-1b.

FIG. 1-2d shows another perspective of the presentation module 1-108 of the computing device 1-10 of FIG. 1-1b.

FIG. 1-2e shows another perspective of the one or more applications 1-126 of the computing device 1-10 of FIG. 1-1b.

FIG. 1-3 is a high-level logic flowchart of a process.

FIG. 1-4a is a high-level logic flowchart of a process depicting alternate implementations of the subjective user state data acquisition operation 1-302 of FIG. 1-3.

FIG. 1-4b is a high-level logic flowchart of a process depicting alternate implementations of the subjective user state data acquisition operation 1-302 of FIG. 1-3.

FIG. 1-4c is a high-level logic flowchart of a process depicting alternate implementations of the subjective user state data acquisition operation 1-302 of FIG. 1-3.

FIG. 1-4d is a high-level logic flowchart of a process depicting alternate implementations of the subjective user state data acquisition operation 1-302 of FIG. 1-3.

FIG. 1-4e is a high-level logic flowchart of a process depicting alternate implementations of the subjective user state data acquisition operation 1-302 of FIG. 1-3.

FIG. 1-5a is a high-level logic flowchart of a process depicting alternate implementations of the objective context data acquisition operation 1-304 of FIG. 1-3.

FIG. 1-5b is a high-level logic flowchart of a process depicting alternate implementations of the objective context data acquisition operation 1-304 of FIG. 1-3.

FIG. 1-5c is a high-level logic flowchart of a process depicting alternate implementations of the objective context data acquisition operation 1-304 of FIG. 1-3.

FIG. 1-5d is a high-level logic flowchart of a process depicting alternate implementations of the objective context data acquisition operation 1-304 of FIG. 1-3.

FIG. 1-5e is a high-level logic flowchart of a process depicting alternate implementations of the objective context data acquisition operation 1-304 of FIG. 1-3.

FIG. 1-6a is a high-level logic flowchart of a process depicting alternate implementations of the correlation operation 1-306 of FIG. 1-3.

FIG. 1-6b is a high-level logic flowchart of a process depicting alternate implementations of the correlation operation 1-306 of FIG. 1-3.

FIG. 1-7 is a high-level logic flowchart of another process.

FIG. 1-8a is a high-level logic flowchart of a process depicting alternate implementations of the presentation operation 1-708 of FIG. 1-7.

FIG. 1-8b is a high-level logic flowchart of a process depicting alternate implementations of the presentation operation 1-708 of FIG. 1-7.

FIGS. 2-1a and 2-1b show a high-level block diagram of a network device operating in a network environment.

FIG. 2-2a shows another perspective of the subjective user state data acquisition module 2-102 of the computing device 2-10 of FIG. 2-1b.

FIG. 2-2b shows another perspective of the objective occurrence data acquisition module 2-104 of the computing device 2-10 of FIG. 2-1b.

FIG. 2-2c shows another perspective of the correlation module 2-106 of the computing device 2-10 of FIG. 2-1b.

FIG. 2-2d shows another perspective of the presentation module 2-108 of the computing device 2-10 of FIG. 2-1b.

FIG. 2-2e shows another perspective of the one or more applications 2-126 of the computing device 2-10 of FIG. 2-1b.

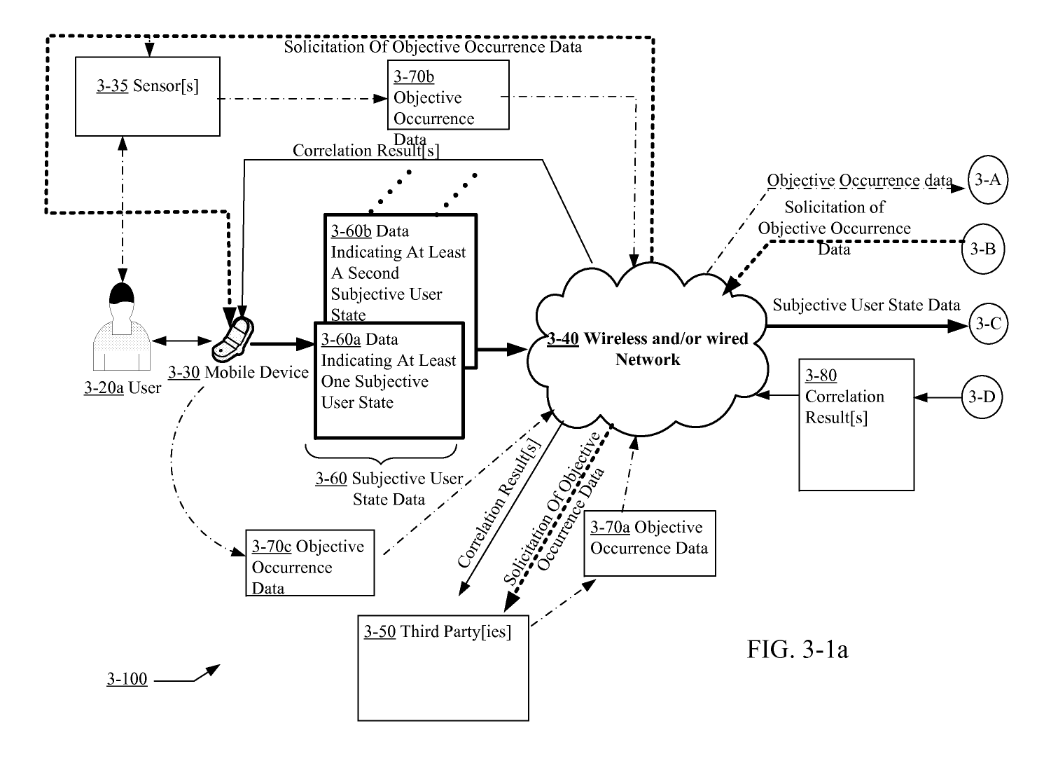

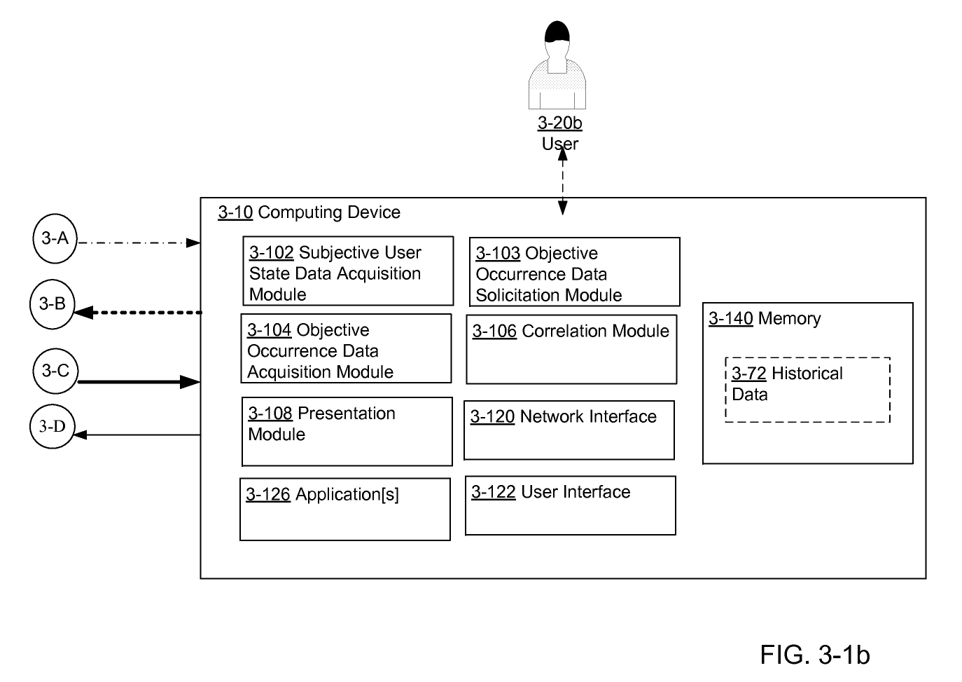

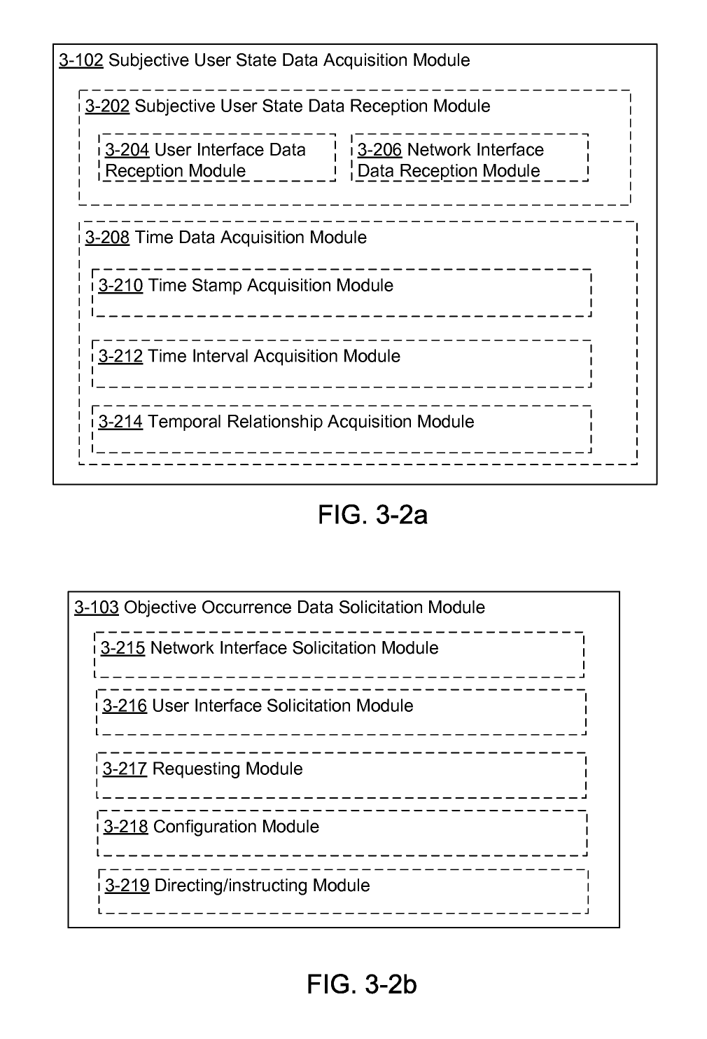

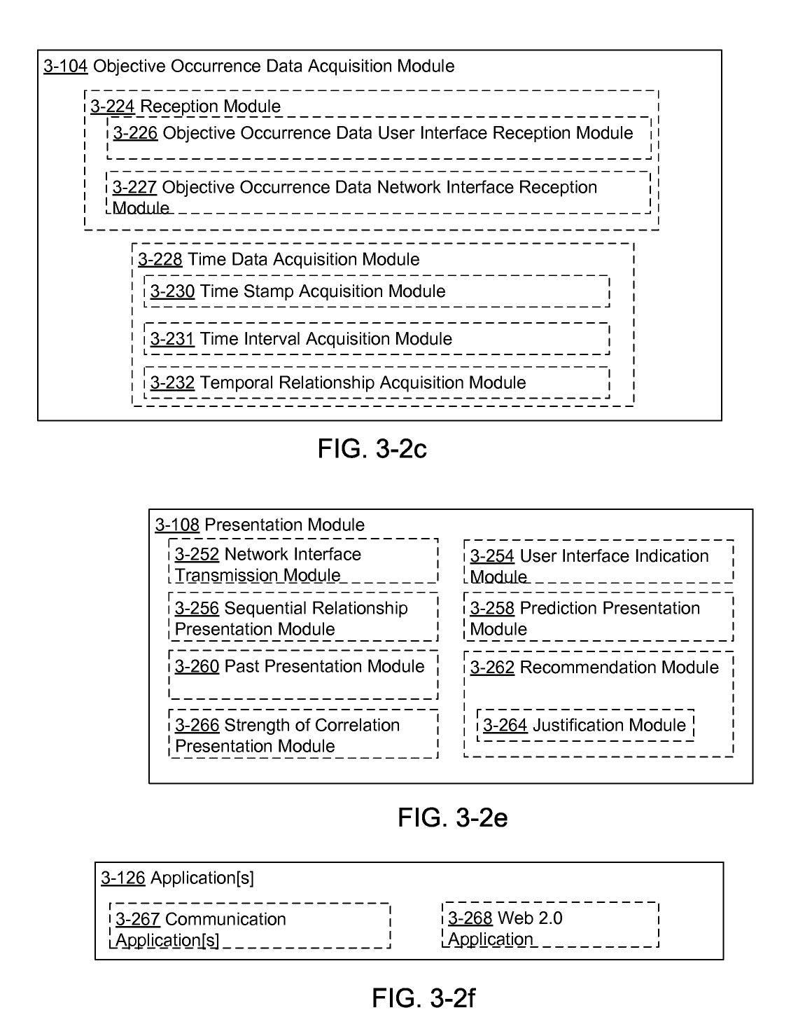

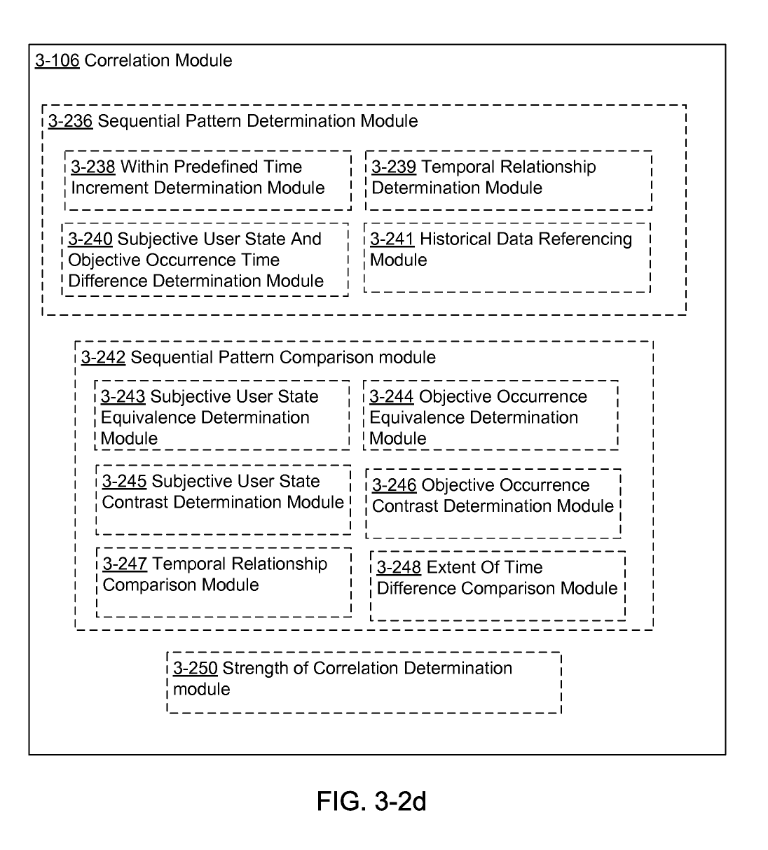

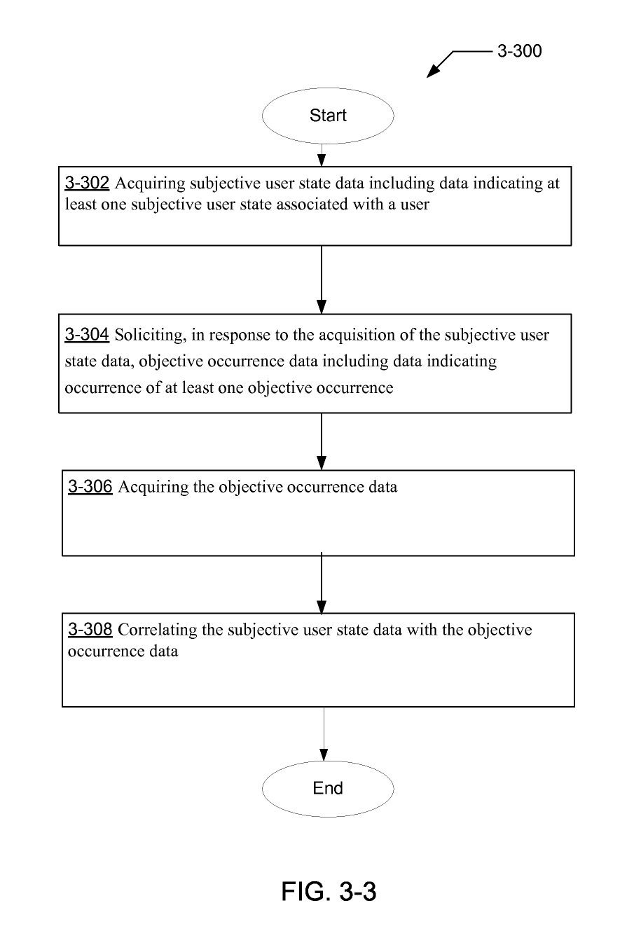

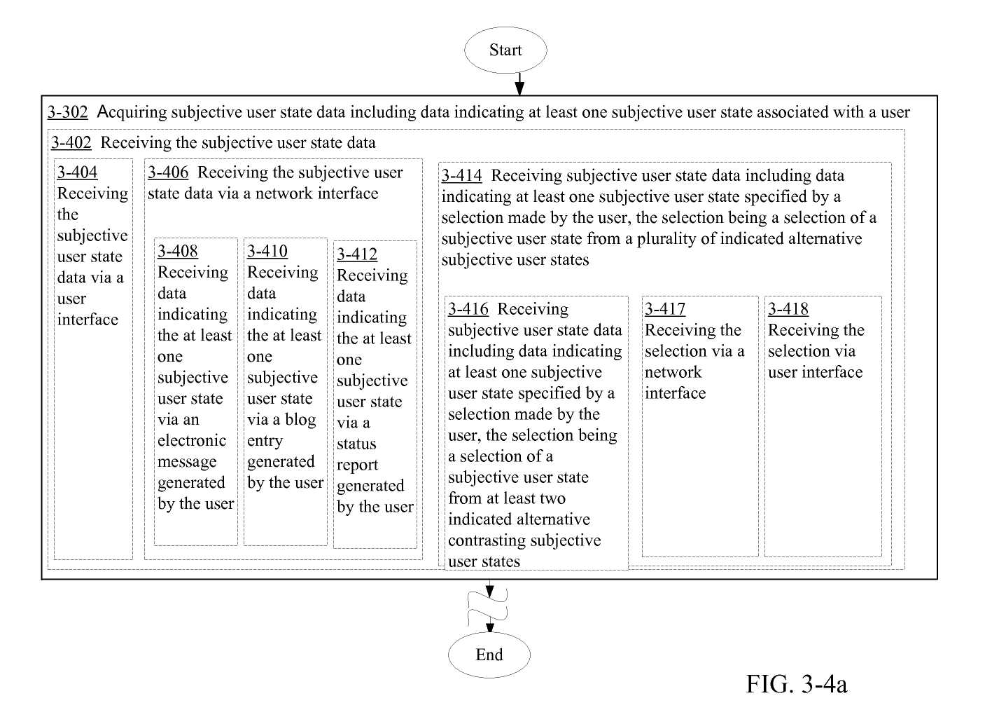

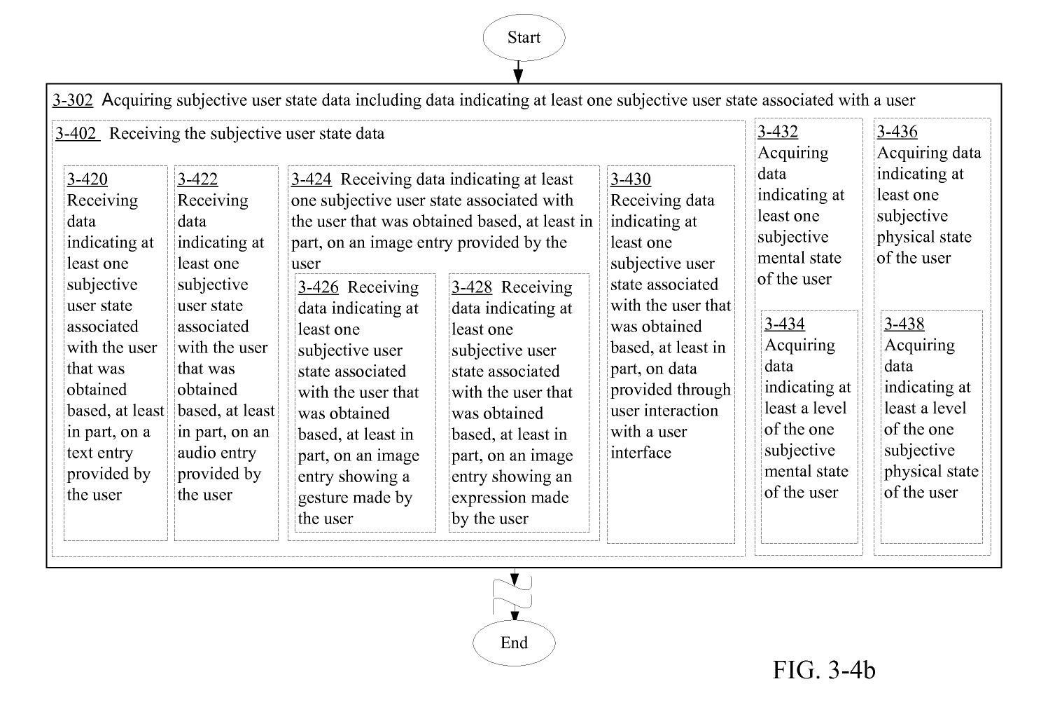

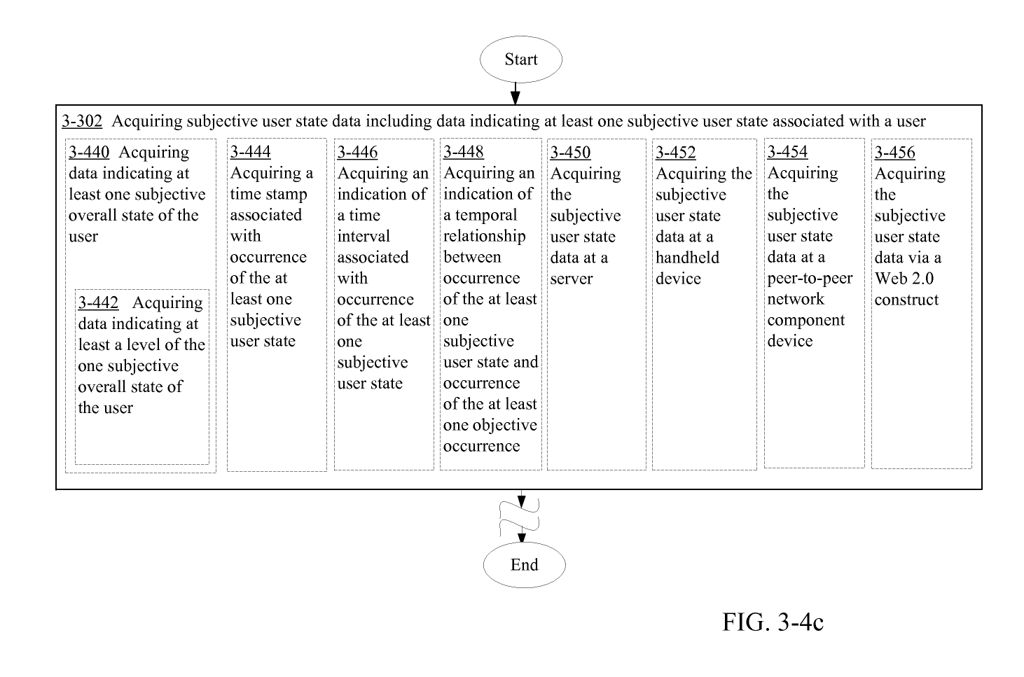

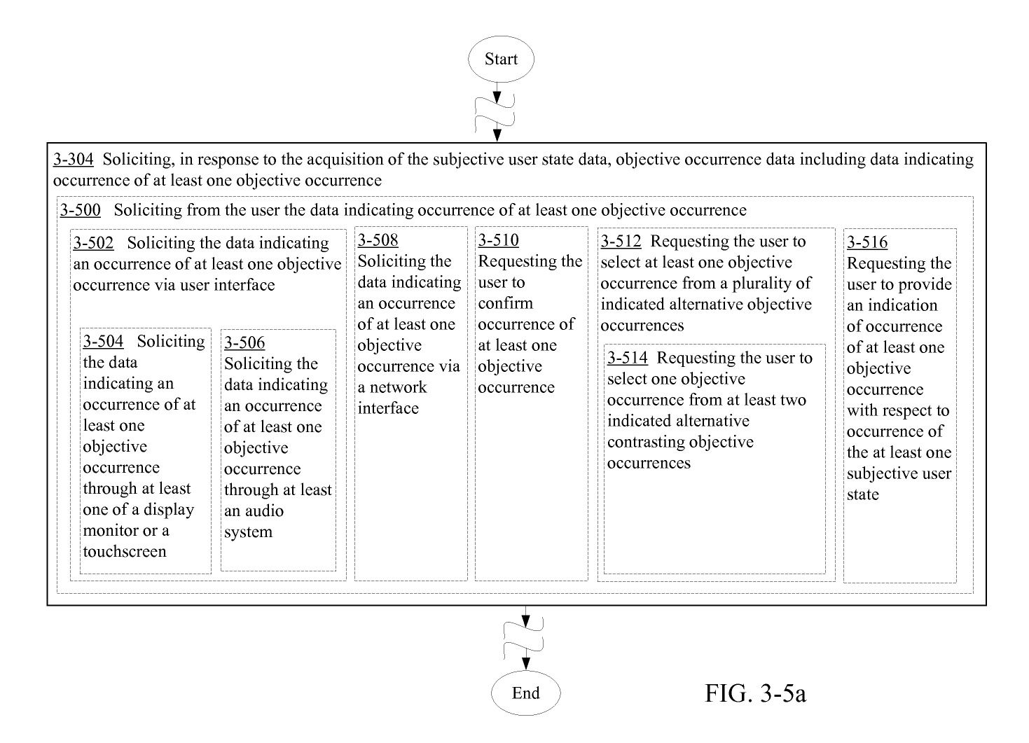

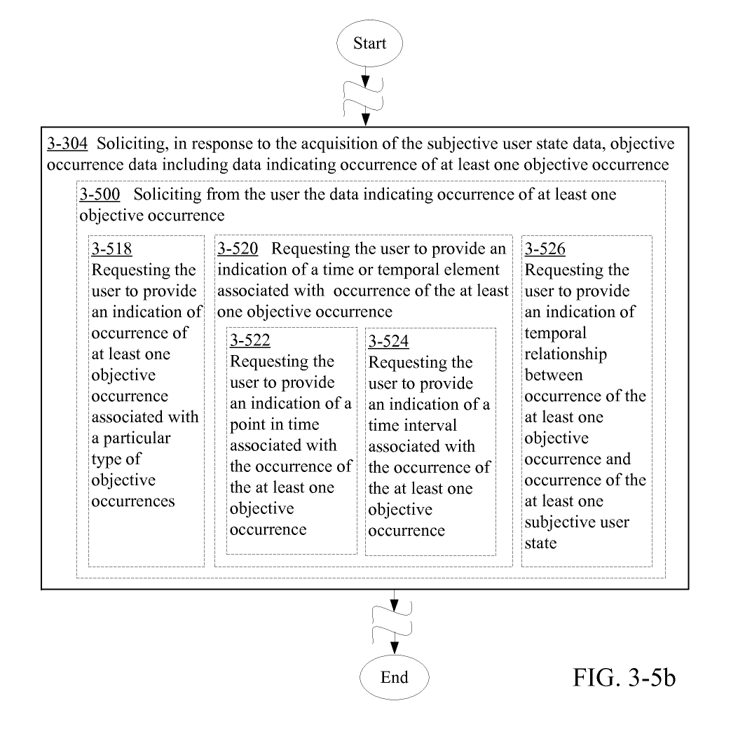

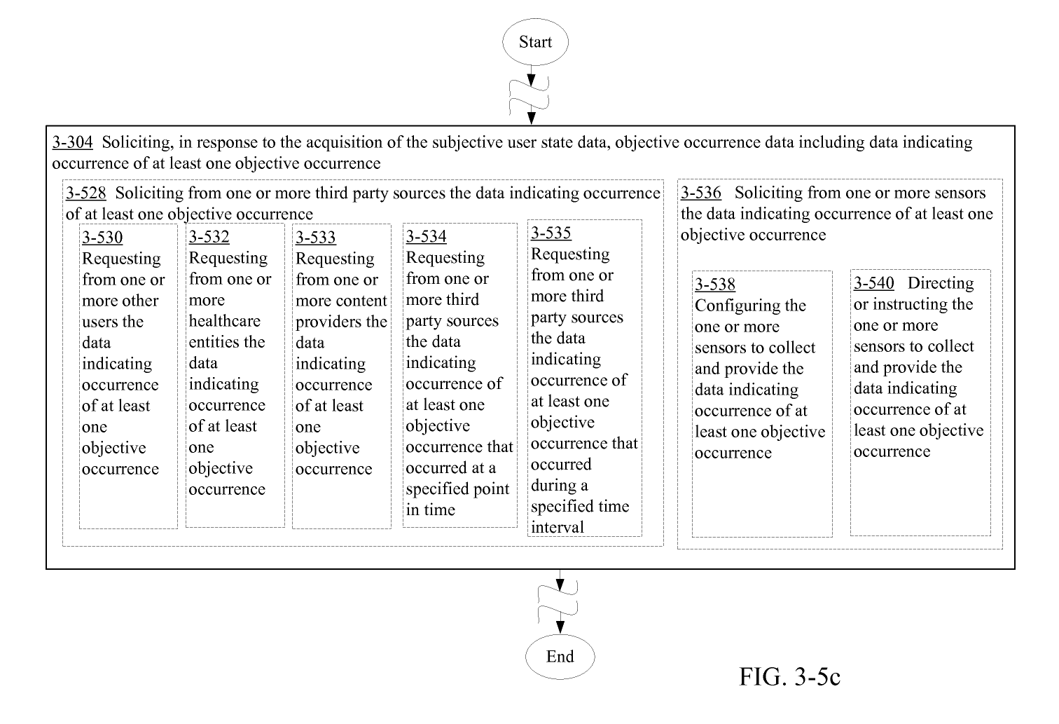

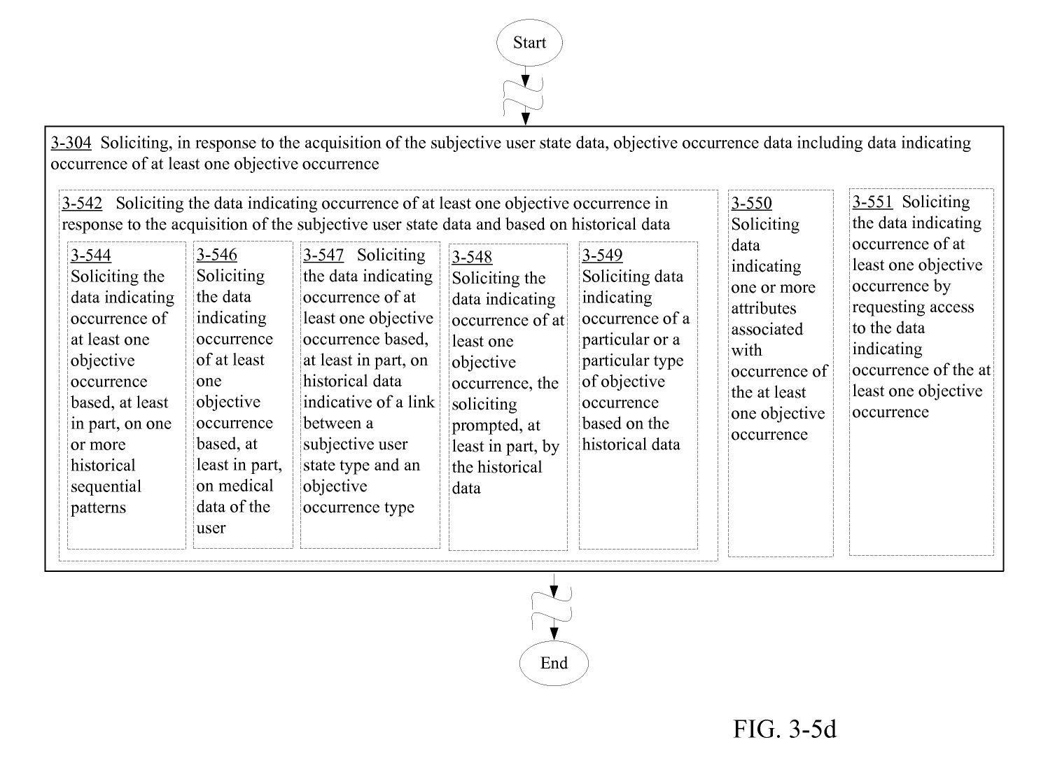

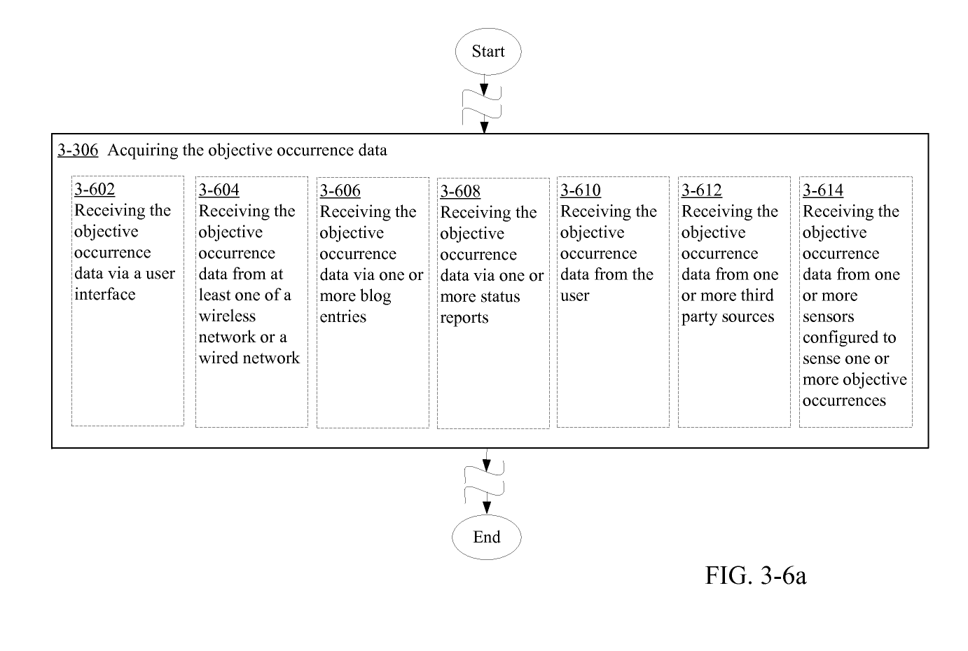

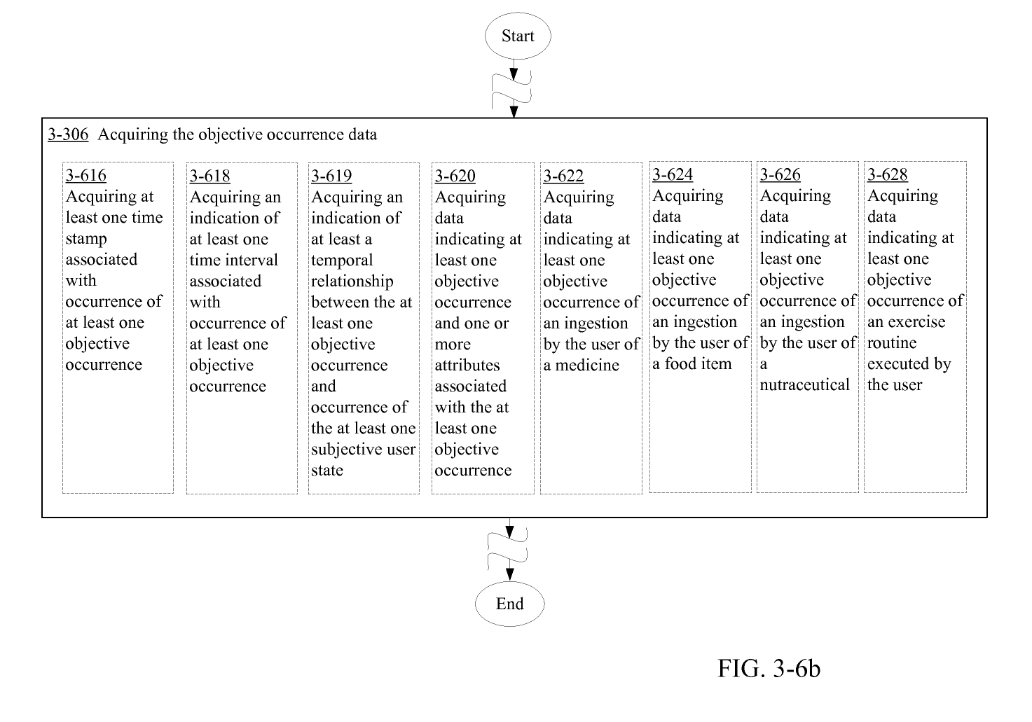

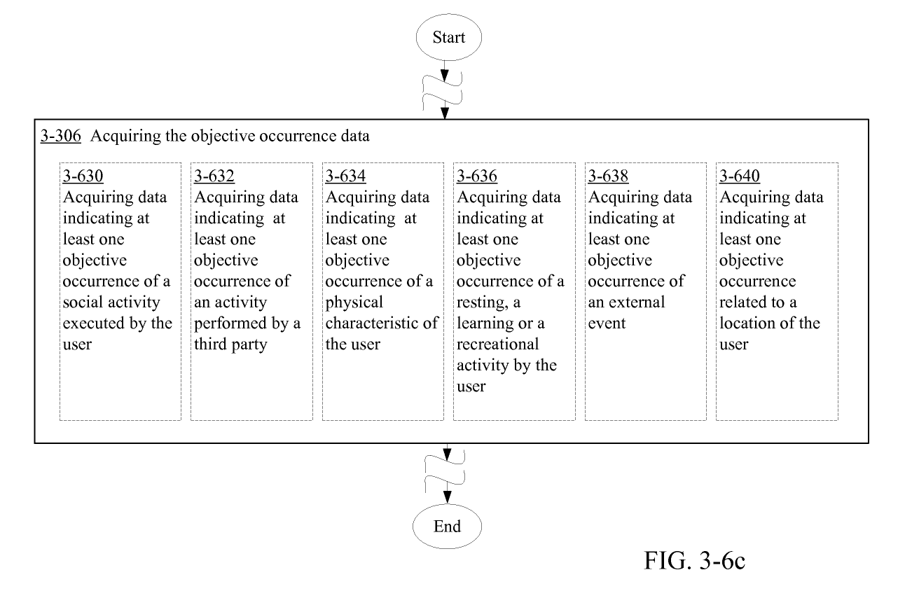

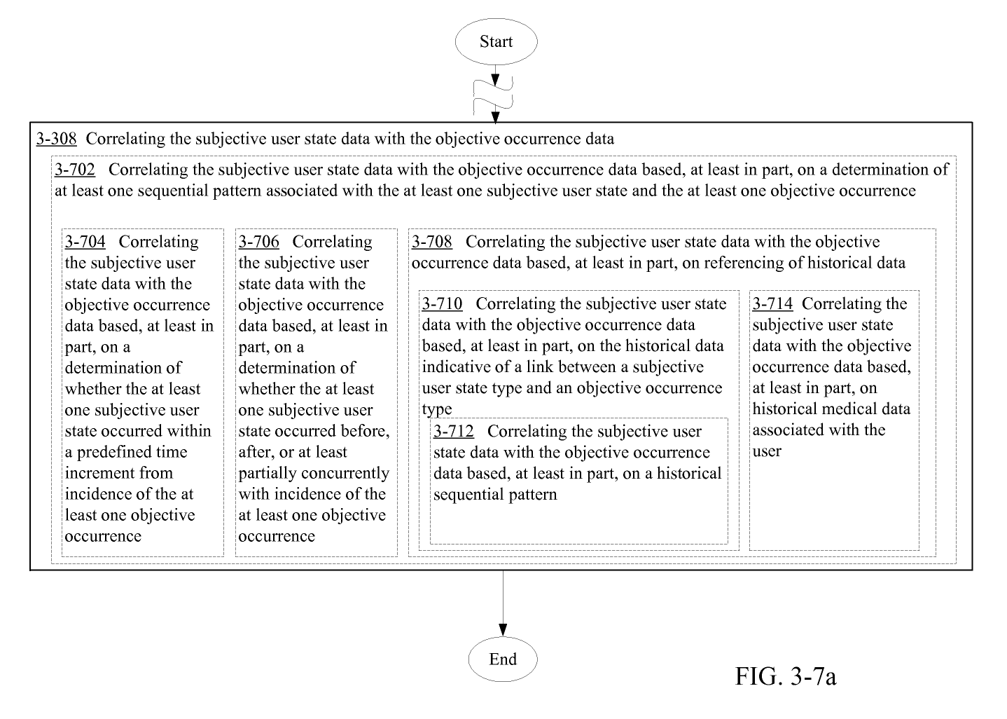

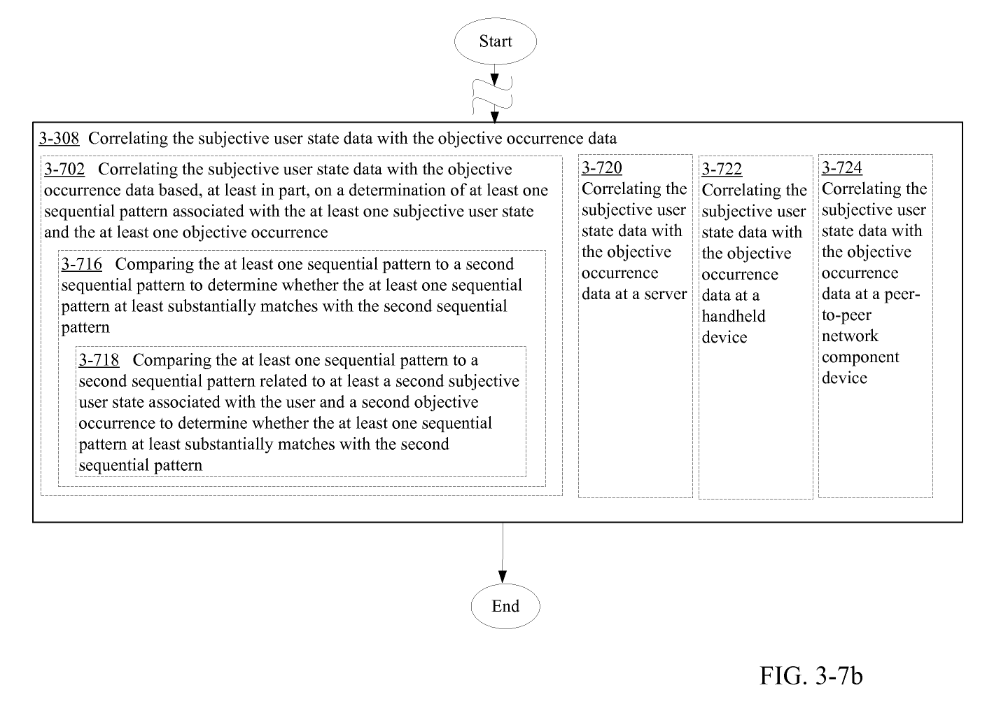

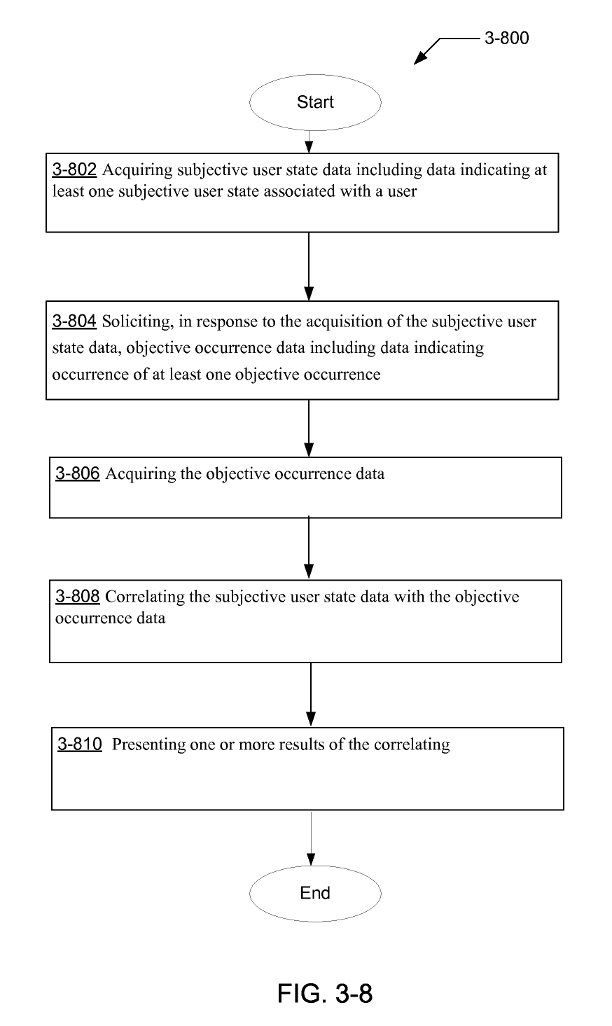

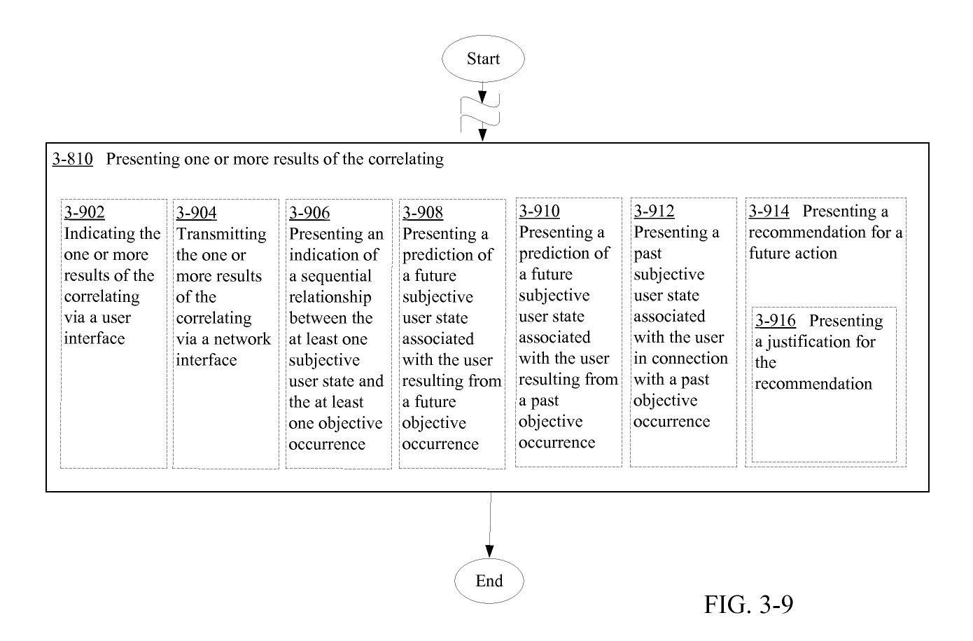

FIG. 2-3 is a high-level logic flowchart of a process.

FIG. 2-4a is a high-level logic flowchart of a process depicting alternate implementations of the subjective user state data acquisition operation 2-302 of FIG. 2-3.

FIG. 2-4b is a high-level logic flowchart of a process depicting alternate implementations of the subjective user state data acquisition operation 2-302 of FIG. 2-3.

FIG. 2-4c is a high-level logic flowchart of a process depicting alternate implementations of the subjective user state data acquisition operation 2-302 of FIG. 2-3.

FIG. 2-4d is a high-level logic flowchart of a process depicting alternate implementations of the subjective user state data acquisition operation 2-302 of FIG. 2-3.

FIG. 2-4e is a high-level logic flowchart of a process depicting alternate implementations of the subjective user state data acquisition operation 2-302 of FIG. 2-3.

FIG. 2-5a is a high-level logic flowchart of a process depicting alternate implementations of the objective occurrence data acquisition operation 2-304 of FIG. 2-3.

FIG. 2-5b is a high-level logic flowchart of a process depicting alternate implementations of the objective occurrence data acquisition operation 2-304 of FIG. 2-3.

FIG. 2-5c is a high-level logic flowchart of a process depicting alternate implementations of the objective occurrence data acquisition operation 2-304 of FIG. 2-3.

FIG. 2-5d is a high-level logic flowchart of a process depicting alternate implementations of the objective occurrence data acquisition operation 2-304 of FIG. 2-3.

FIG. 2-5e is a high-level logic flowchart of a process depicting alternate implementations of the objective occurrence data acquisition operation 2-304 of FIG. 2-3.

FIG. 2-5f is a high-level logic flowchart of a process depicting alternate implementations of the objective occurrence data acquisition operation 2-304 of FIG. 2-3.

FIG. 2-5g is a high-level logic flowchart of a process depicting alternate implementations of the objective occurrence data acquisition operation 2-304 of FIG. 2-3.

FIG. 2-5h is a high-level logic flowchart of a process depicting alternate implementations of the objective occurrence data acquisition operation 2-304 of FIG. 2-3.

FIG. 2-5i is a high-level logic flowchart of a process depicting alternate implementations of the objective occurrence data acquisition operation 2-304 of FIG. 2-3.

FIG. 2-5j is a high-level logic flowchart of a process depicting alternate implementations of the objective occurrence data acquisition operation 2-304 of FIG. 2-3.

FIG. 2-5k is a high-level logic flowchart of a process depicting alternate implementations of the objective occurrence data acquisition operation 2-304 of FIG. 2-3.

FIG. 2-6a is a high-level logic flowchart of a process depicting alternate implementations of the correlation operation 2-306 of FIG. 2-3.

FIG. 2-6b is a high-level logic flowchart of a process depicting alternate implementations of the correlation operation 2-306 of FIG. 2-3.

FIG. 2-6c is a high-level logic flowchart of a process depicting alternate implementations of the correlation operation 2-306 of FIG. 2-3.

FIG. 2-6d is a high-level logic flowchart of a process depicting alternate implementations of the correlation operation 2-306 of FIG. 2-3.

FIG. 2-7a is a high-level logic flowchart of a process depicting alternate implementations of the presentation operation 2-308 of FIG. 2-3.

FIG. 2-7b is a high-level logic flowchart of a process depicting alternate implementations of the presentation operation 2-308 of FIG. 2-3.

FIGS. 3-1a and 3-1b show a high-level block diagram of a computing device 3-10 operating in a network environment.

FIG. 3-2a shows another perspective of the subjective user state data acquisition module 3-102 of the computing device 3-10 of FIG. 3-1b.

FIG. 3-2b shows another perspective of the objective occurrence data solicitation module 3-103 of the computing device 3-10 of FIG. 3-1b.

FIG. 3-2c shows another perspective of the objective occurrence data acquisition module 3-104 of the computing device 3-10 of FIG. 3-1b.

FIG. 3-2d shows another perspective of the correlation module 3-106 of the computing device 3-10 of FIG. 3-1b.

FIG. 3-2e shows another perspective of the presentation module 3-108 of the computing device 3-10 of FIG. 3-1b.

FIG. 3-2f shows another perspective of the one or more applications 3-126 of the computing device 3-10 of FIG. 3-1b.

FIG. 3-3 is a high-level logic flowchart of a process.

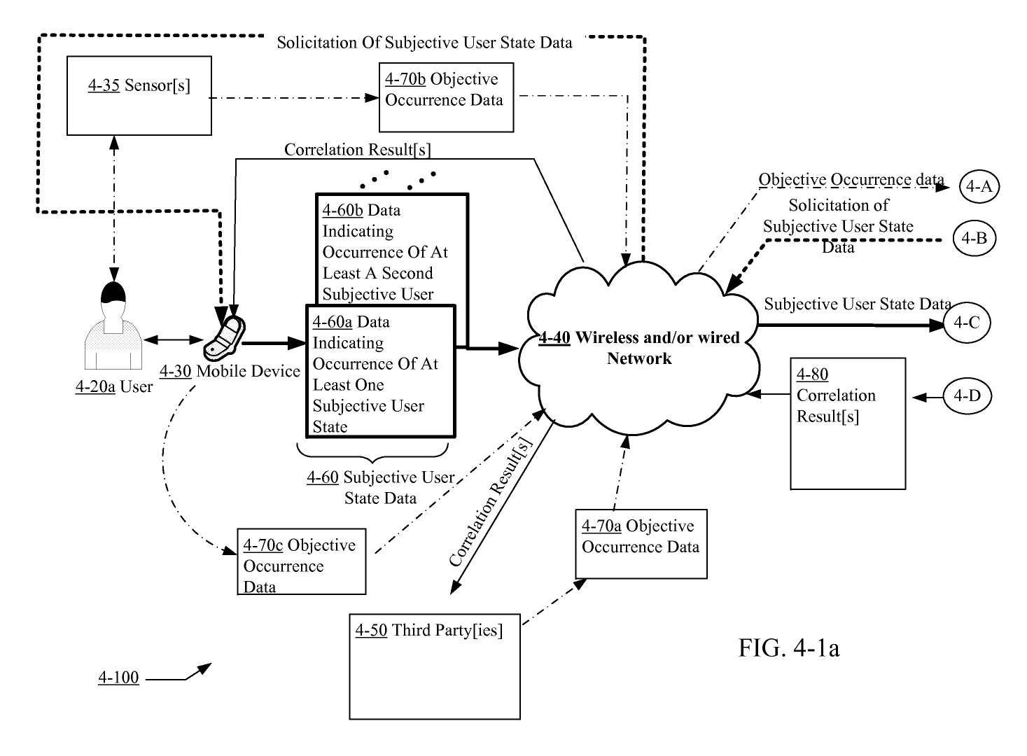

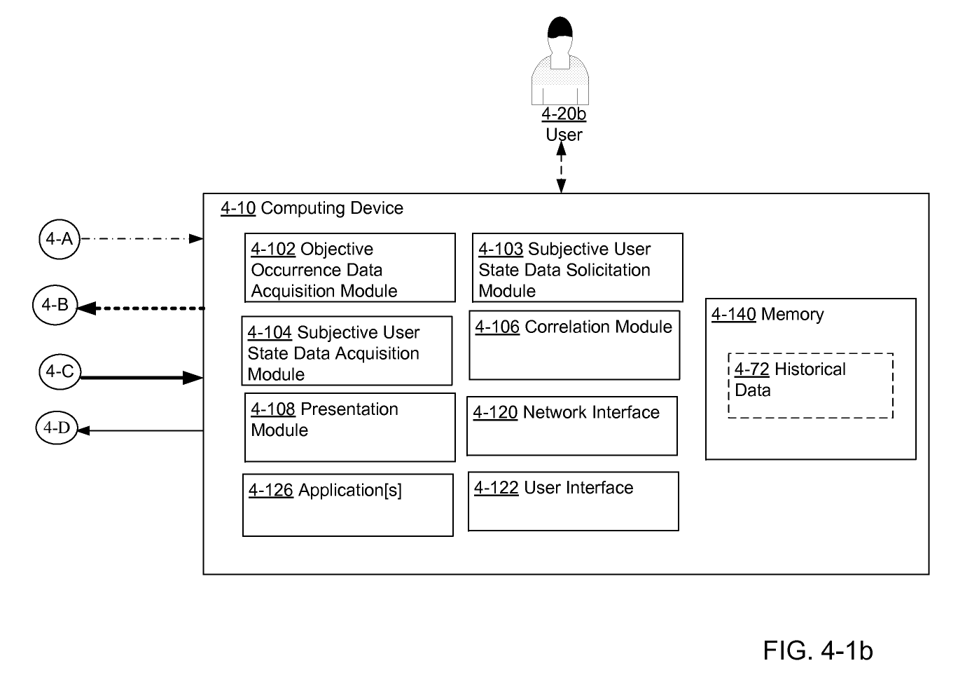

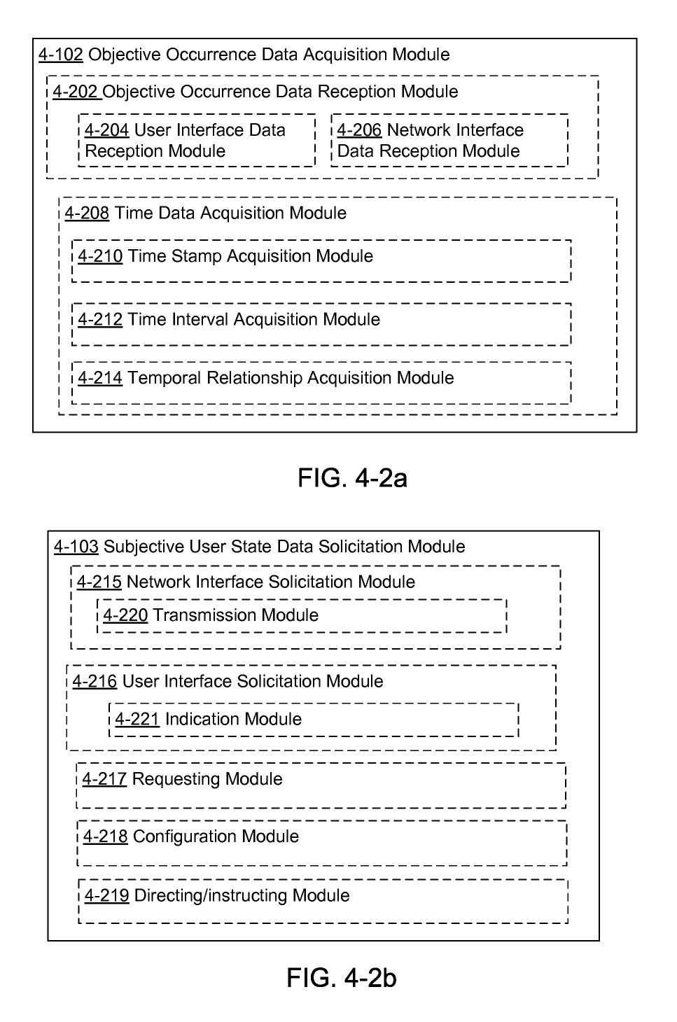

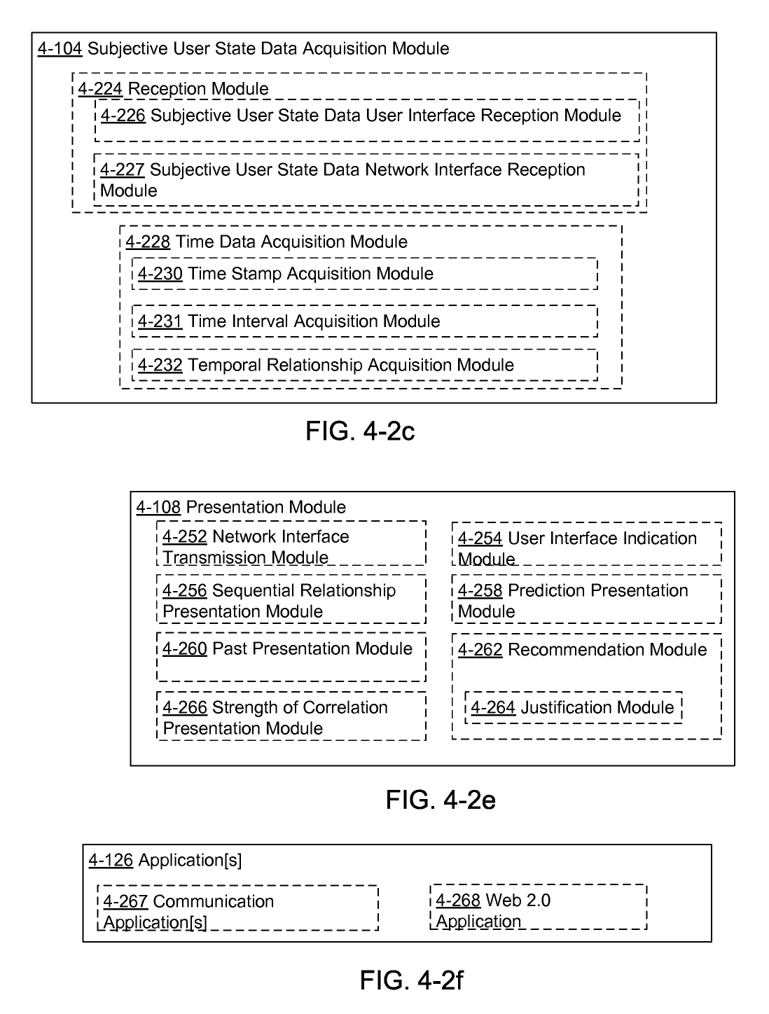

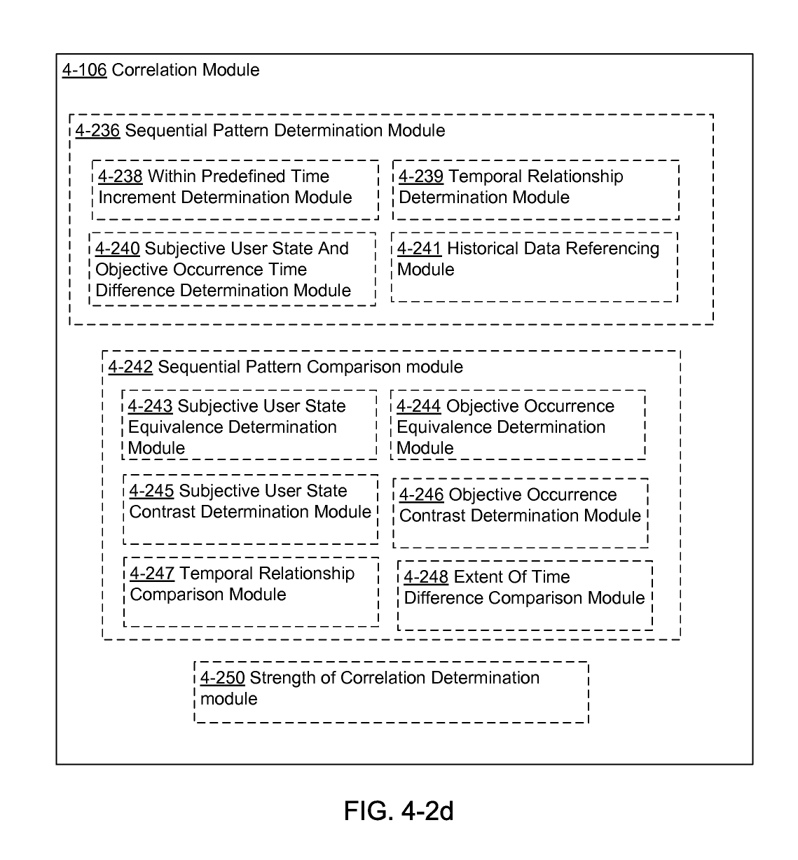

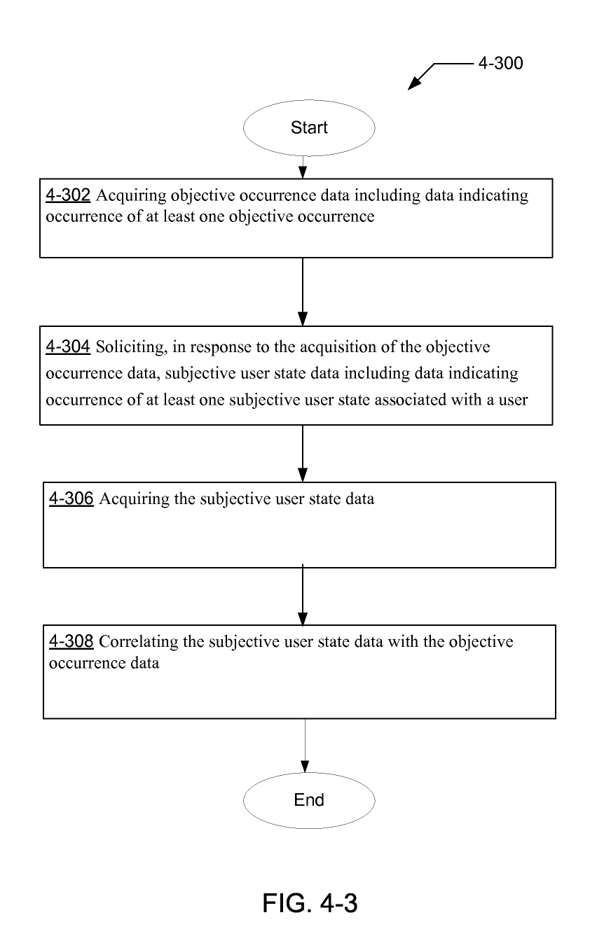

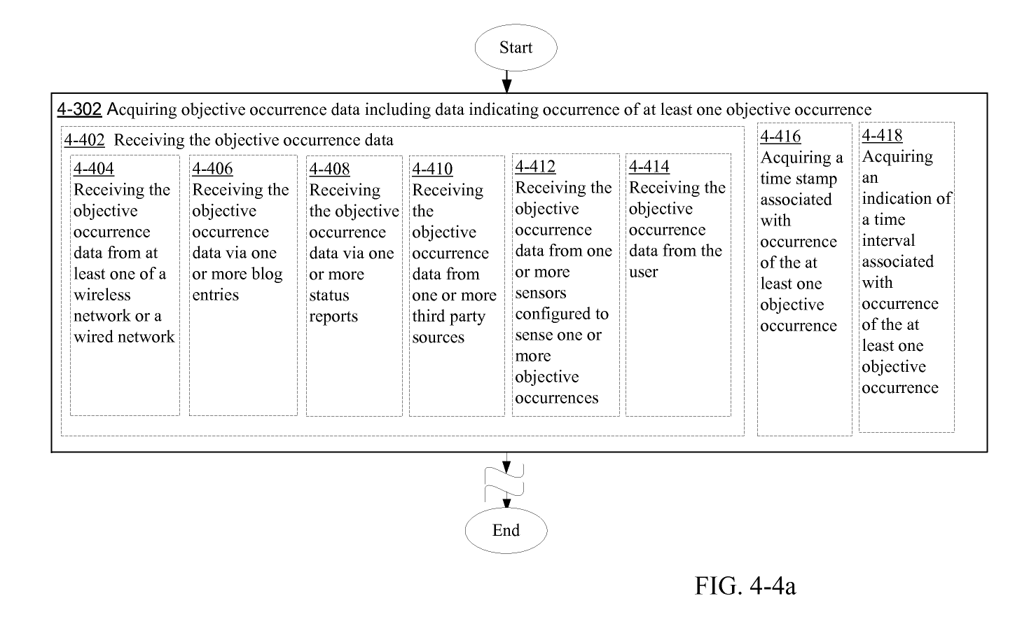

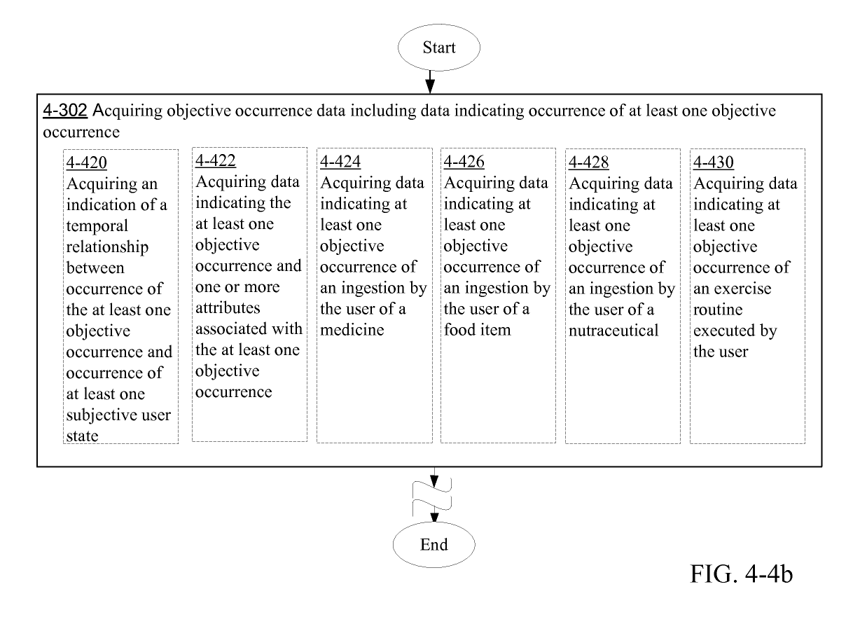

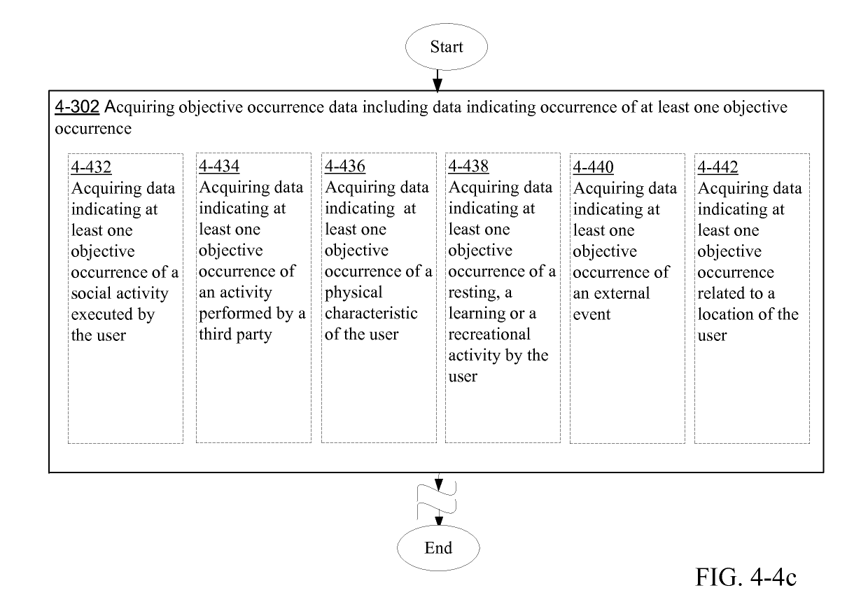

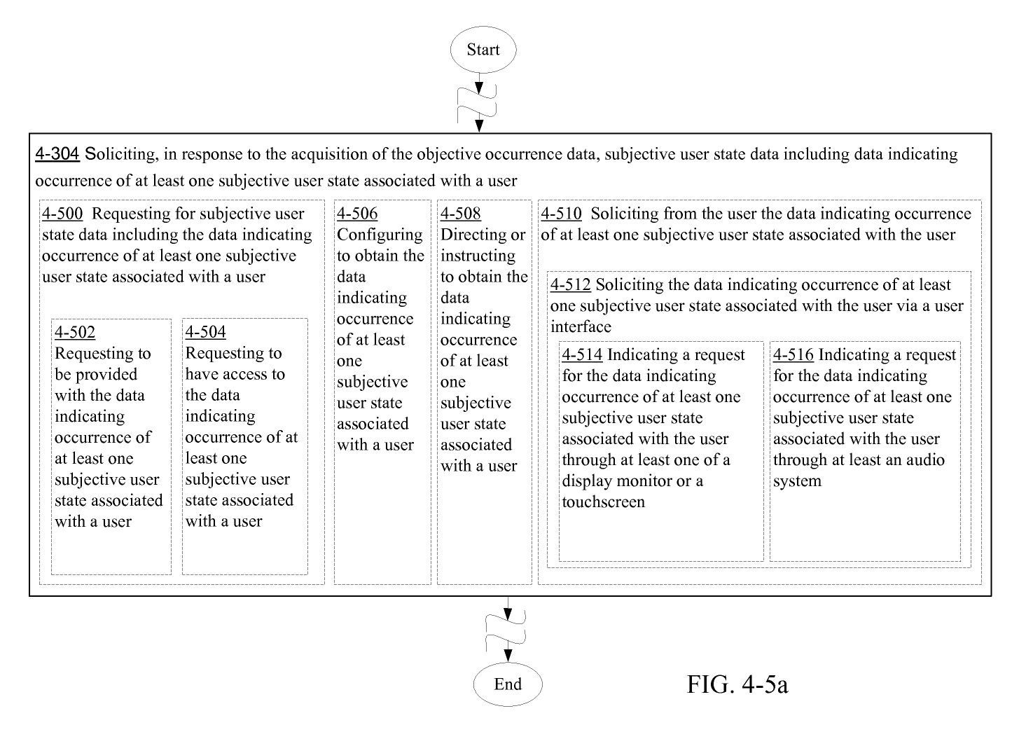

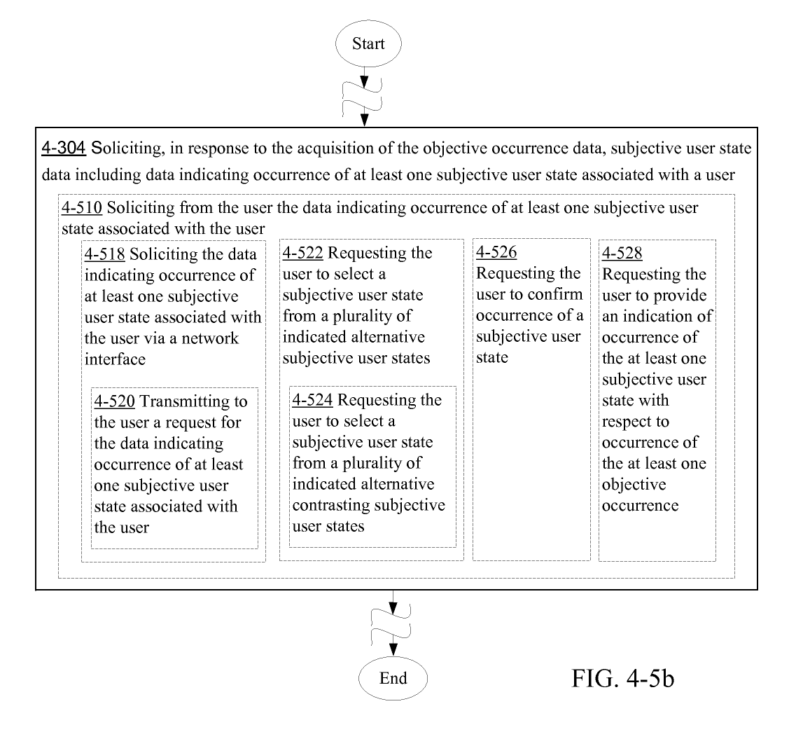

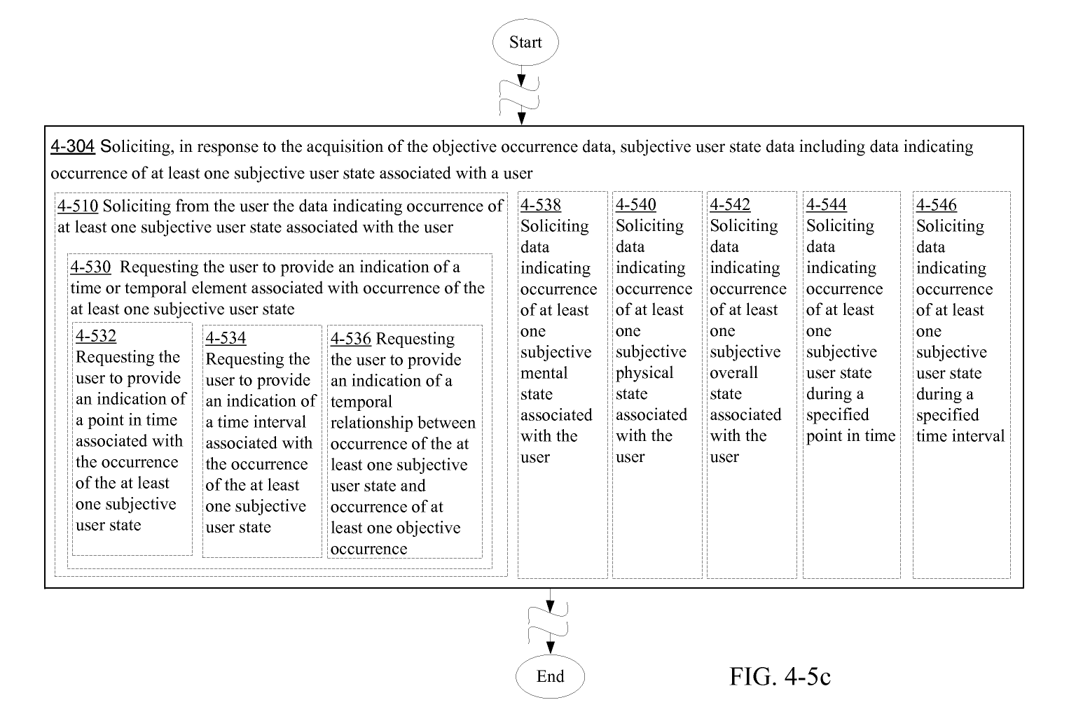

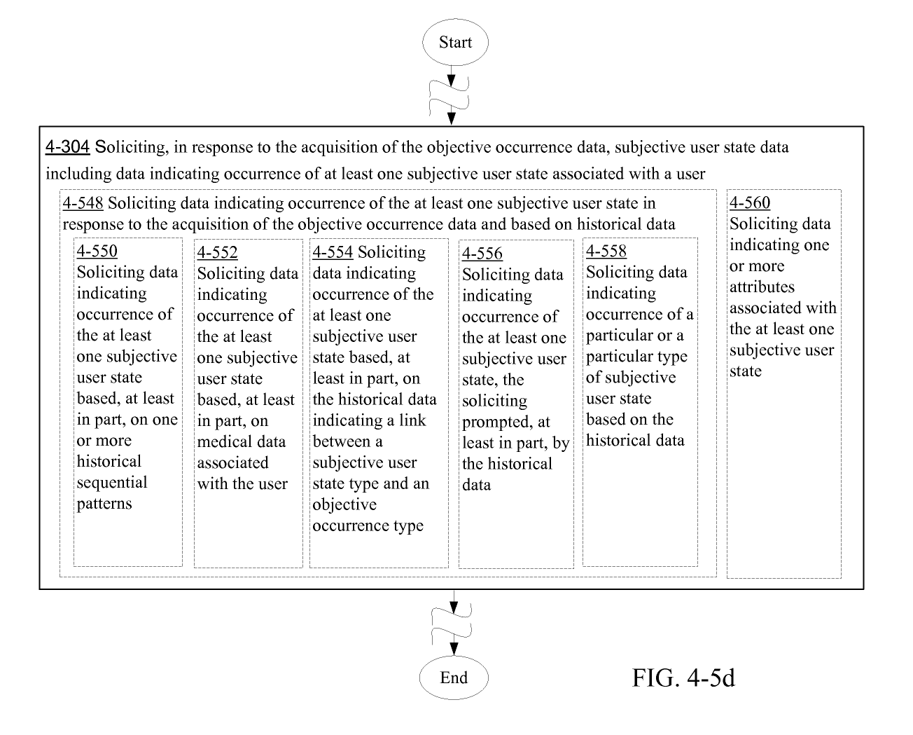

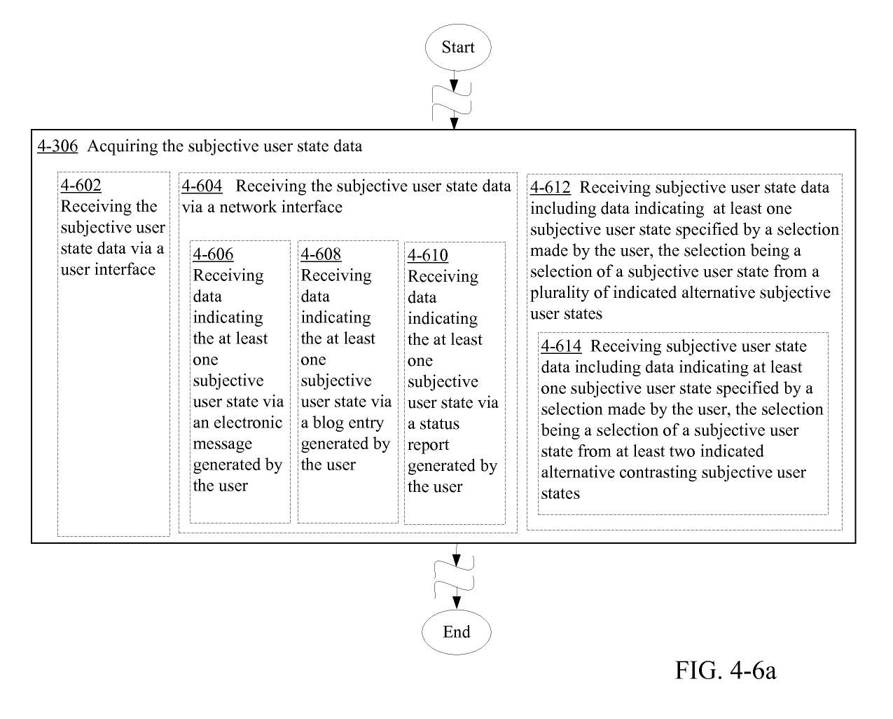

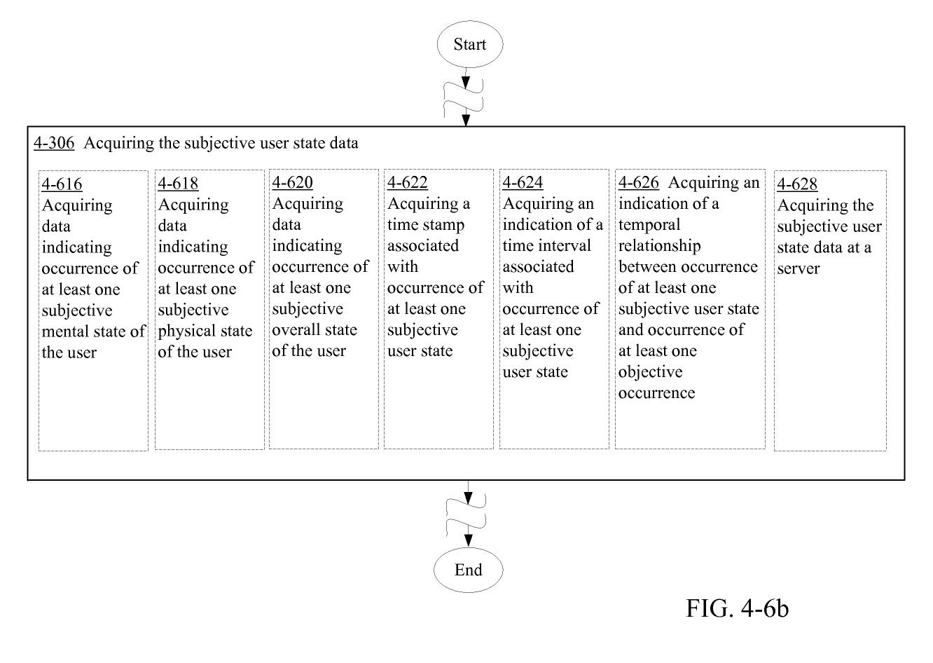

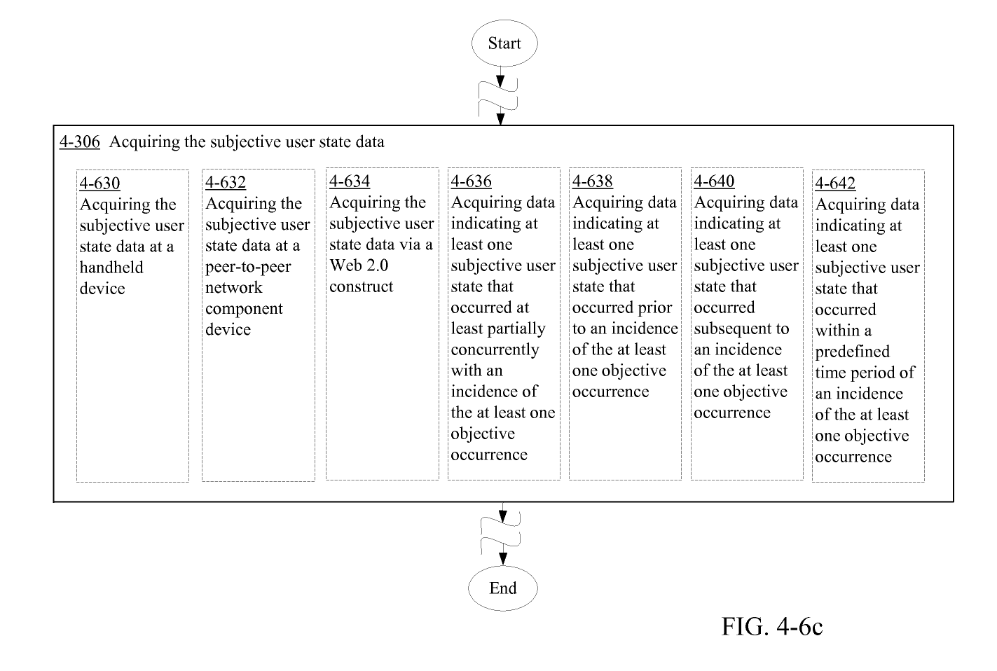

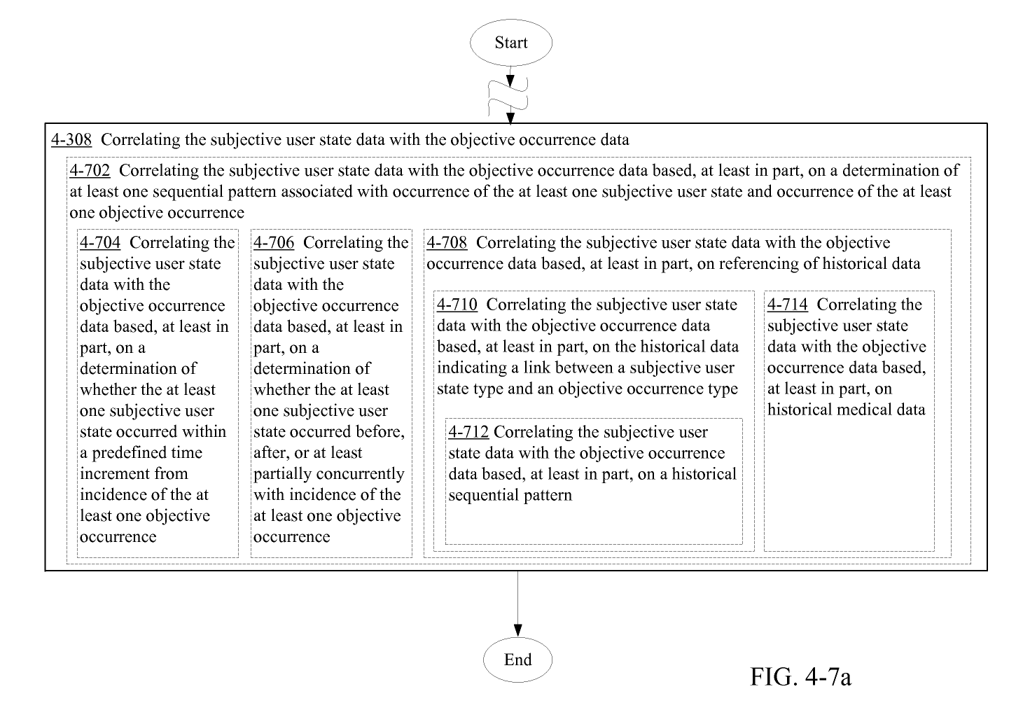

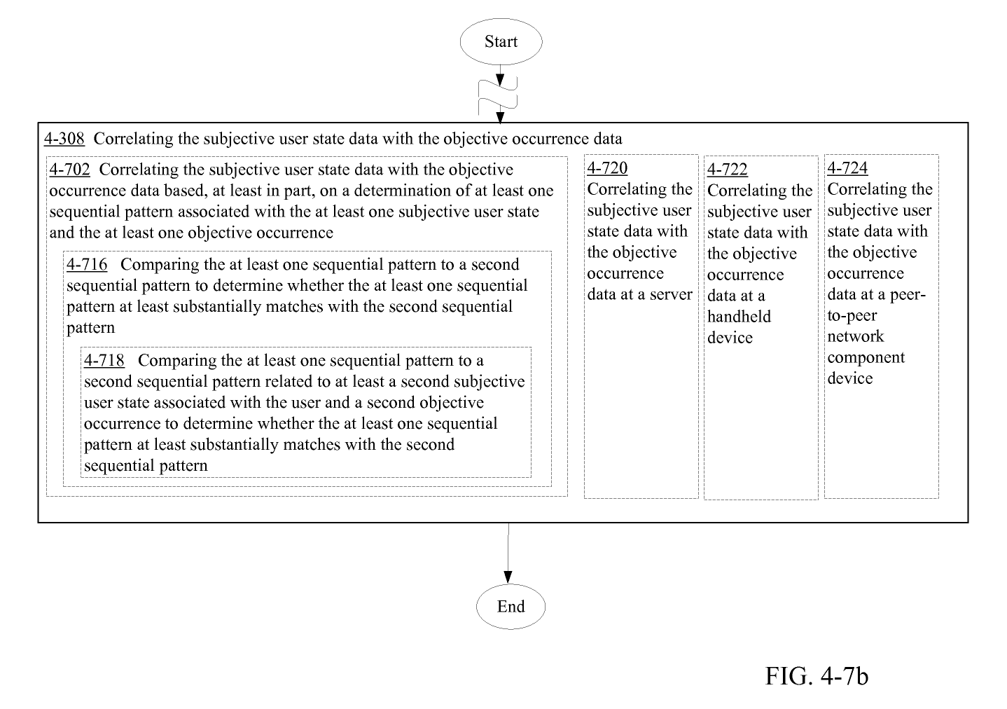

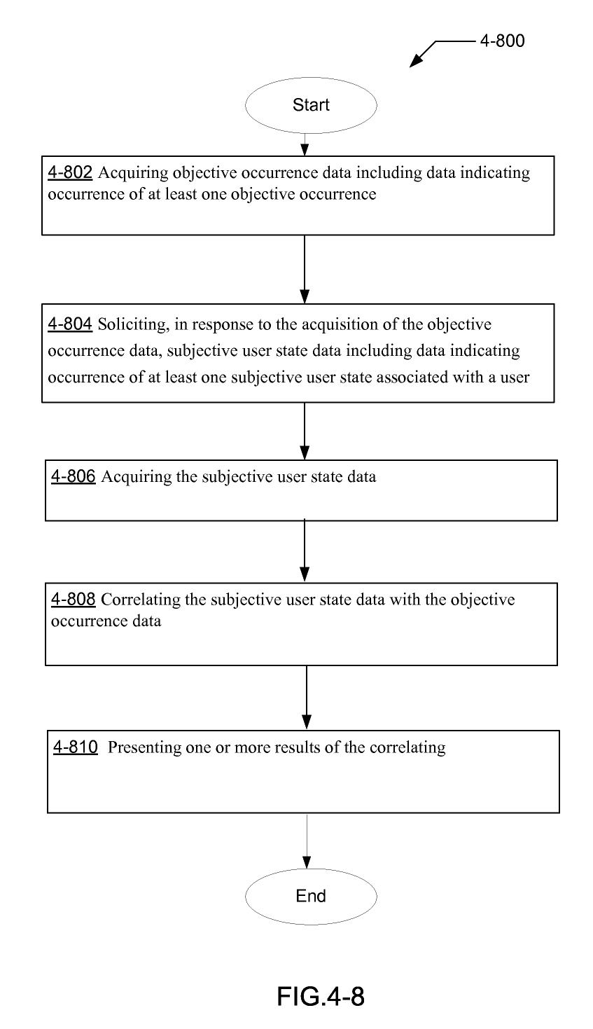

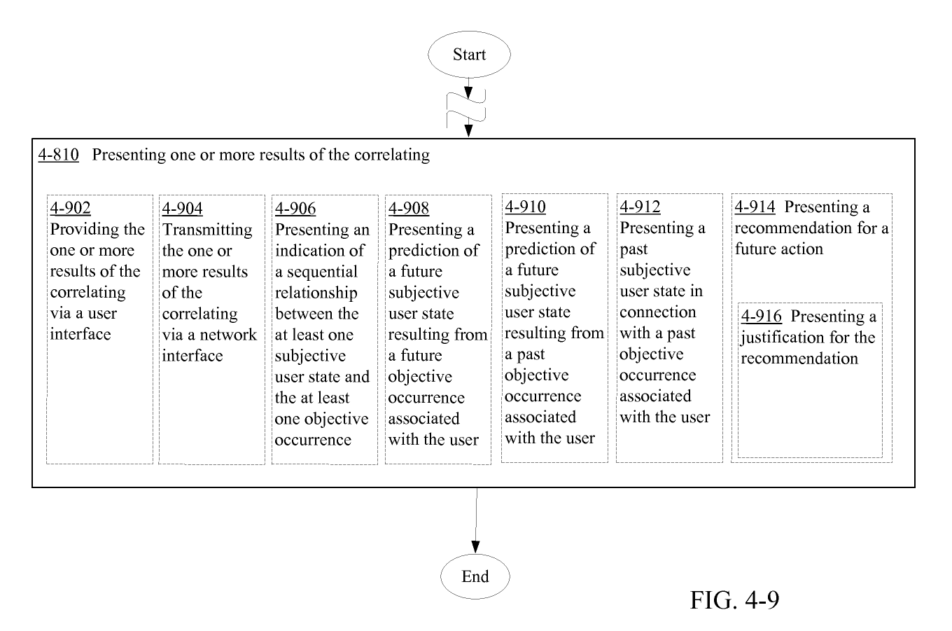

FIG. 3-4a is a high-level logic flowchart of a process depicting alternate implementations of the subjective user state data acquisition operation 3-302 of FIG. 3-3.

FIG. 3-4b is a high-level logic flowchart of a process depicting alternate implementations of the subjective user state data acquisition operation 3-302 of FIG. 3-3.

FIG. 3-4c is a high-level logic flowchart of a process depicting alternate implementations of the subjective user state data acquisition operation 3-302 of FIG. 3-3.

FIG. 3-5a is a high-level logic flowchart of a process depicting alternate implementations of the objective occurrence data solicitation operation 3-304 of FIG. 3-3.

FIG. 3-5b is a high-level logic flowchart of a process depicting alternate implementations of the objective occurrence data solicitation operation 3-304 of FIG. 3-3.

FIG. 3-5c is a high-level logic flowchart of a process depicting alternate implementations of the objective occurrence data solicitation operation 3-304 of FIG. 3-3.

FIG. 3-5d is a high-level logic flowchart of a process depicting alternate implementations of the objective occurrence data solicitation operation 3-304 of FIG. 3-3.

FIG. 3-6a is a high-level logic flowchart of a process depicting alternate implementations of the objective occurrence data acquisition operation 3-306 of FIG. 3-3.

FIG. 3-6b is a high-level logic flowchart of a process depicting alternate implementations of the objective occurrence data acquisition operation 3-306 of FIG. 3-3.

FIG. 3-6c is a high-level logic flowchart of a process depicting alternate implementations of the objective occurrence data acquisition operation 3-306 of FIG. 3-3.

FIG. 3-7a is a high-level logic flowchart of a process depicting alternate implementations of the correlation operation 3-308 of FIG. 3-3.

FIG. 3-7b is a high-level logic flowchart of a process depicting alternate implementations of the correlation operation 3-308 of FIG. 3-3.

FIG. 3-8 is a high-level logic flowchart of another process.

FIG. 3-9 is a high-level logic flowchart of a process depicting alternate implementations of the presentation operation 3-810 of FIG. 3-8.

FIGS. 4-1a and 4-1b show a high-level block diagram of a computing device 4-10 operating in a network environment.

FIG. 4-2a shows another perspective of the objective occurrence data acquisition module 4-102 of the computing device 4-10 of FIG. 4-1b.

FIG. 4-2b shows another perspective of the subjective user state data solicitation module 4-103 of the computing device 4-10 of FIG. 4-1b.

FIG. 4-2c shows another perspective of the subjective user state data acquisition module 4-104 of the computing device 4-10 of FIG. 4-1b.

FIG. 4-2d shows another perspective of the correlation module 4-106 of the computing device 4-10 of FIG. 4-1b.

FIG. 4-2e shows another perspective of the presentation module 4-108 of the computing device 4-10 of FIG. 4-1b.

FIG. 4-2f shows another perspective of the one or more applications 4-126 of the computing device 4-10 of FIG. 4-1b.

FIG. 4-3 is a high-level logic flowchart of a process.

FIG. 4-4a is a high-level logic flowchart of a process depicting alternate implementations of the objective occurrence data acquisition operation 4-302 of FIG. 4-3.

FIG. 4-4b is a high-level logic flowchart of a process depicting alternate implementations of the objective occurrence data acquisition operation 4-302 of FIG. 4-3.

FIG. 4-4c is a high-level logic flowchart of a process depicting alternate implementations of the objective occurrence data acquisition operation 4-302 of FIG. 4-3.

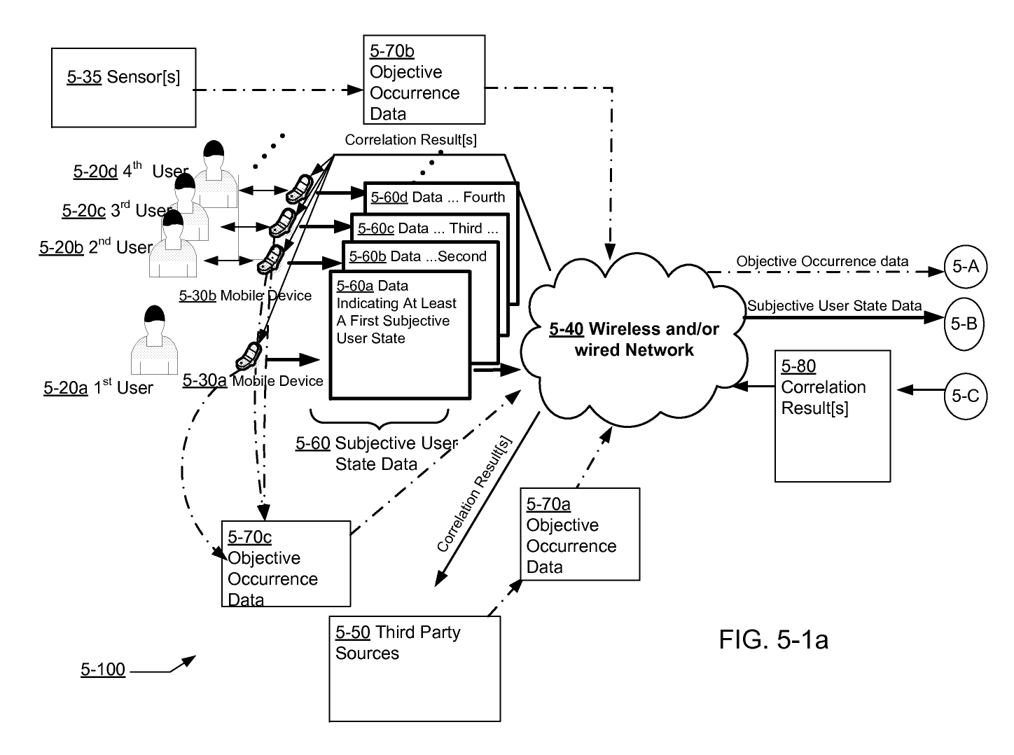

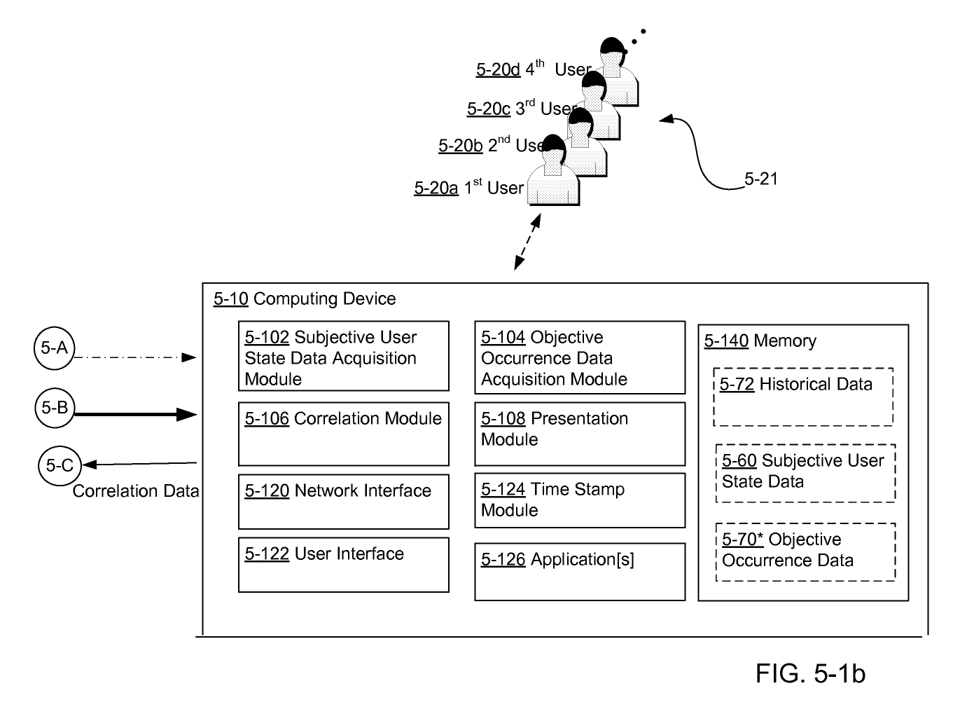

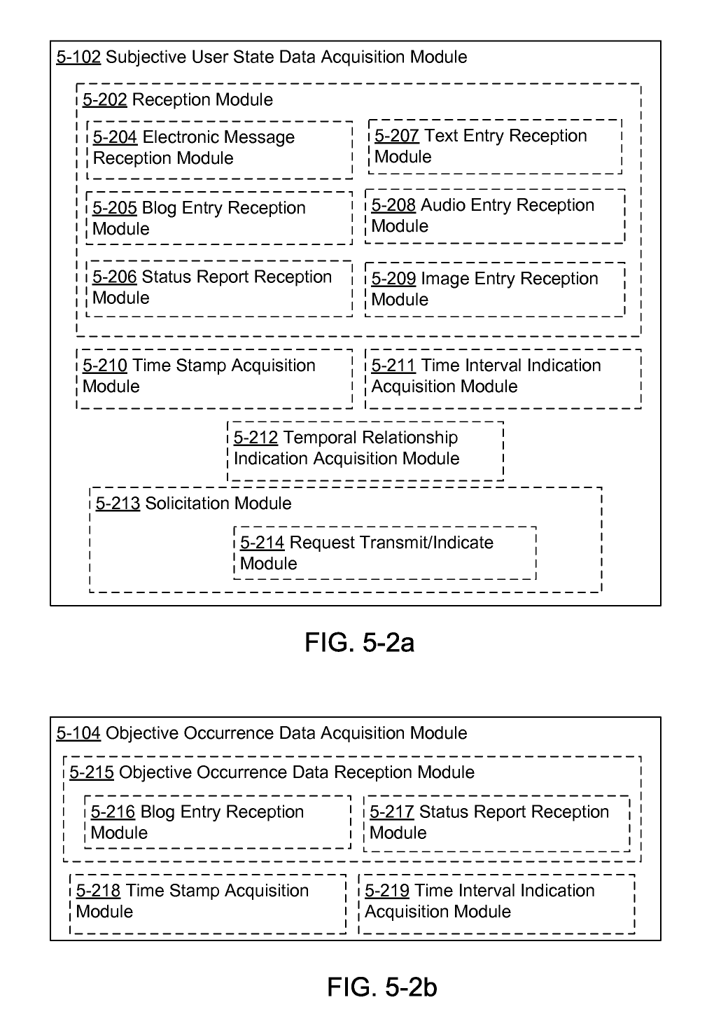

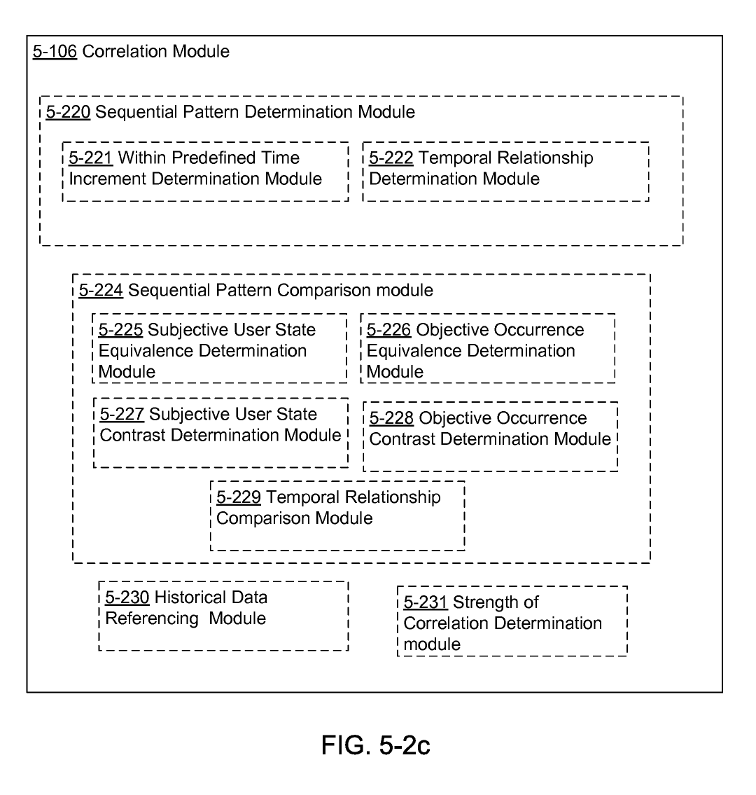

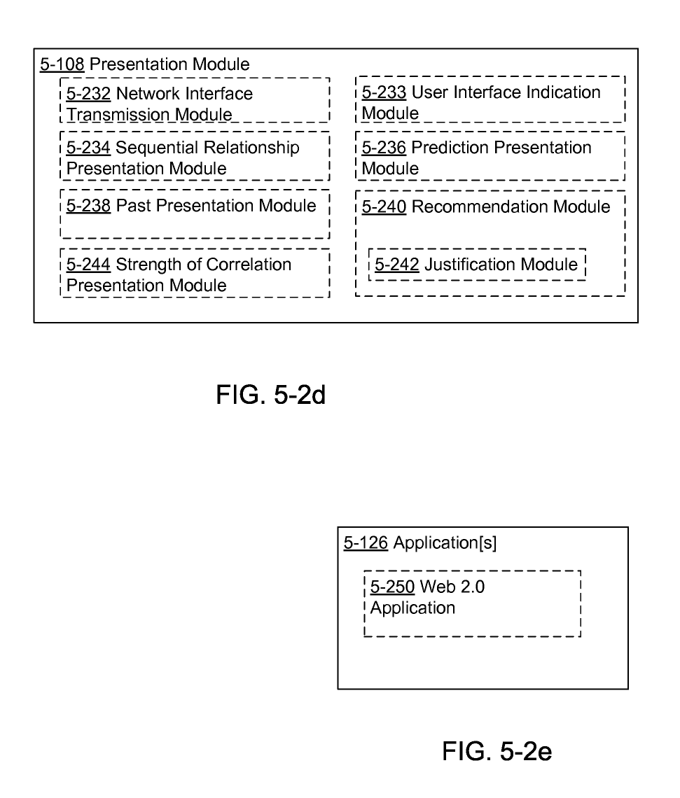

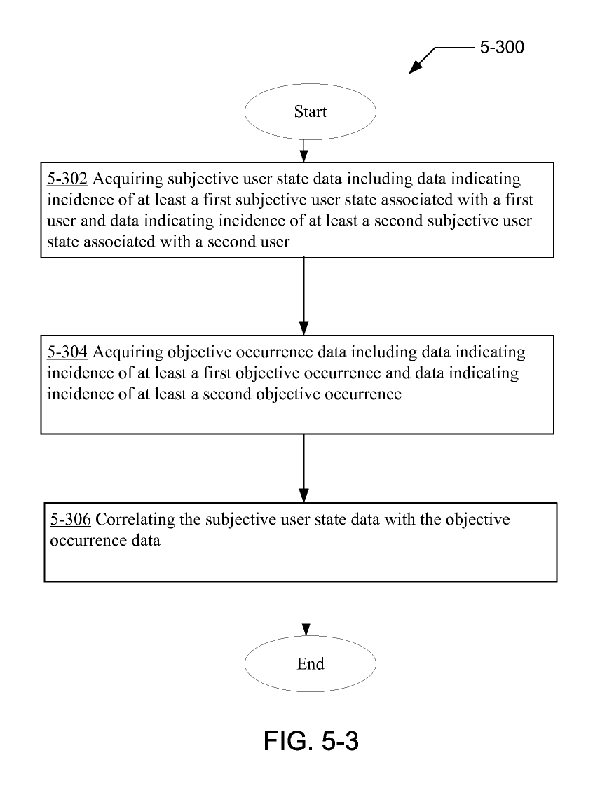

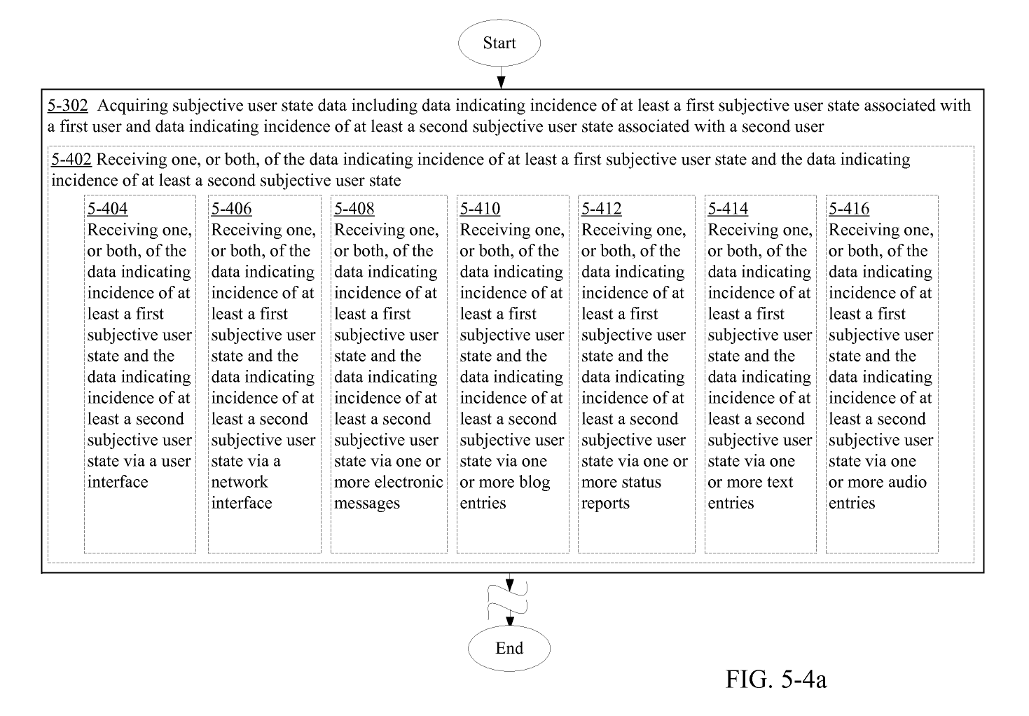

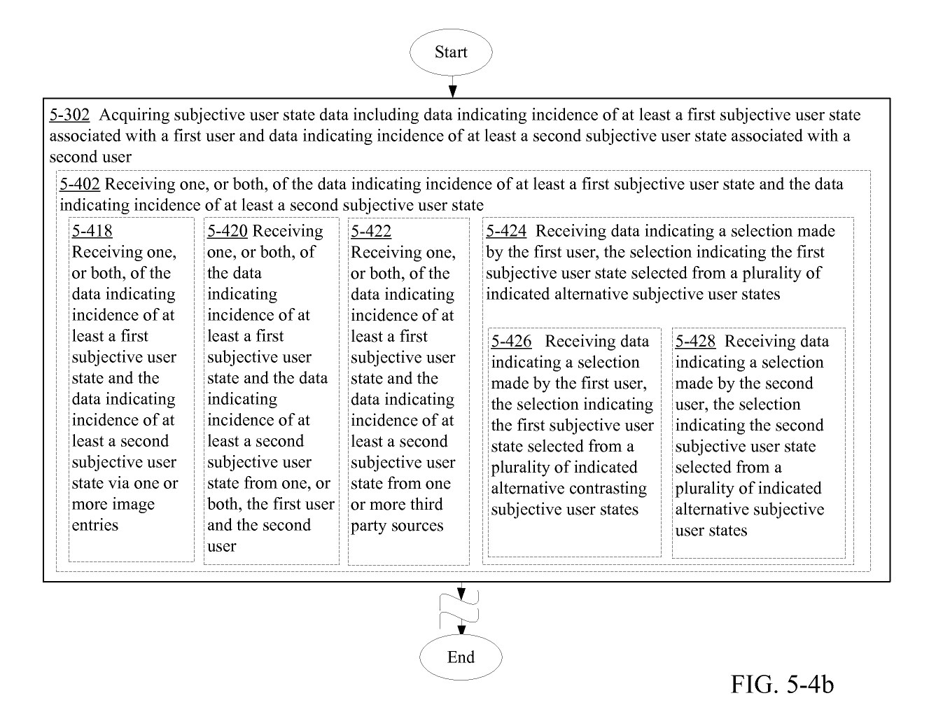

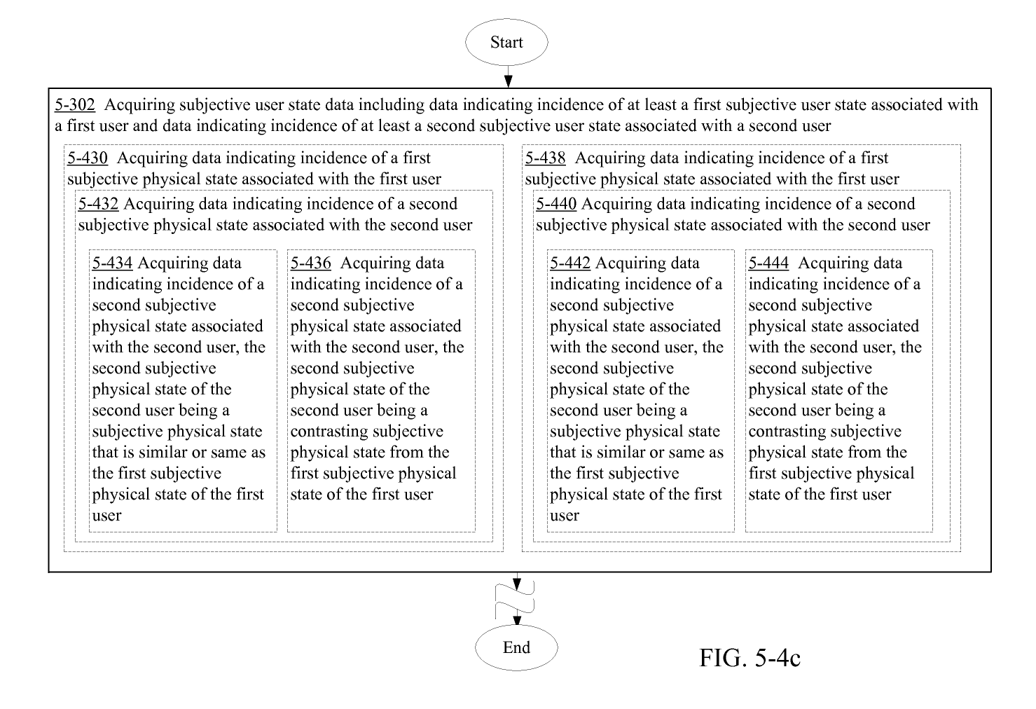

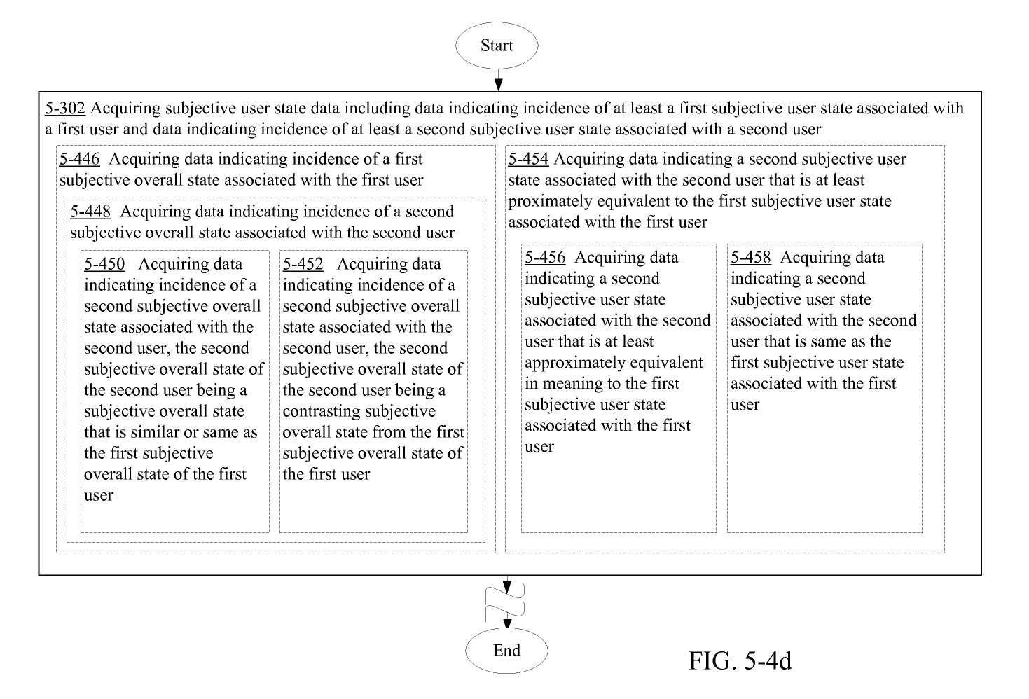

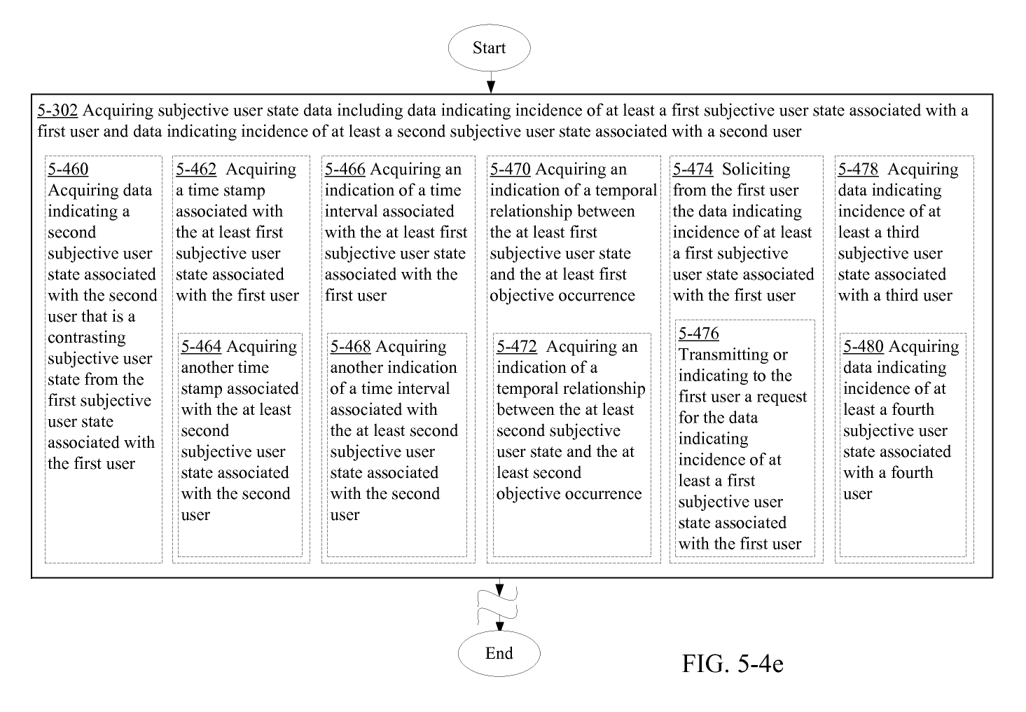

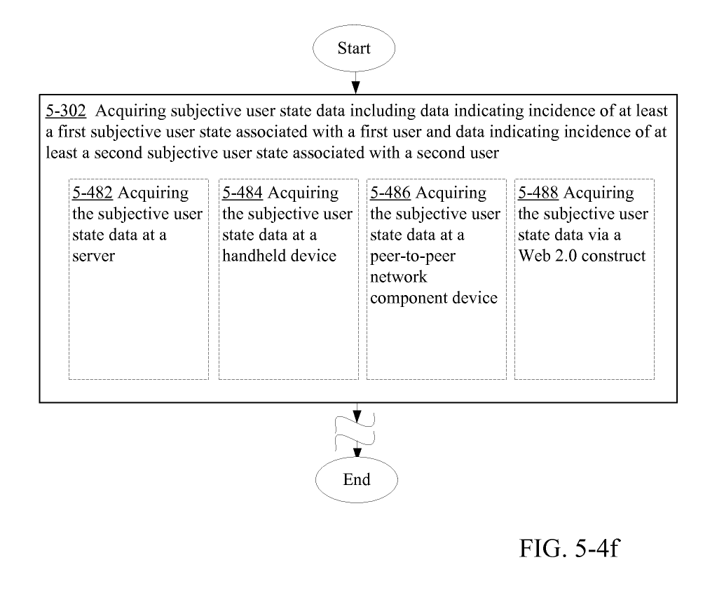

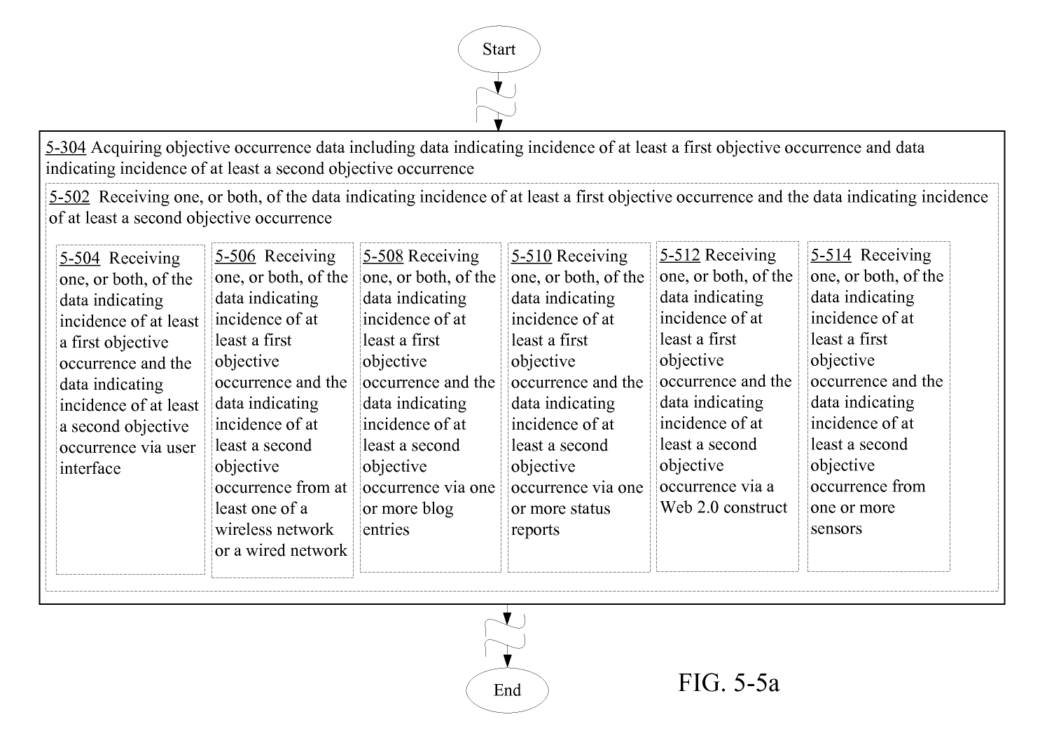

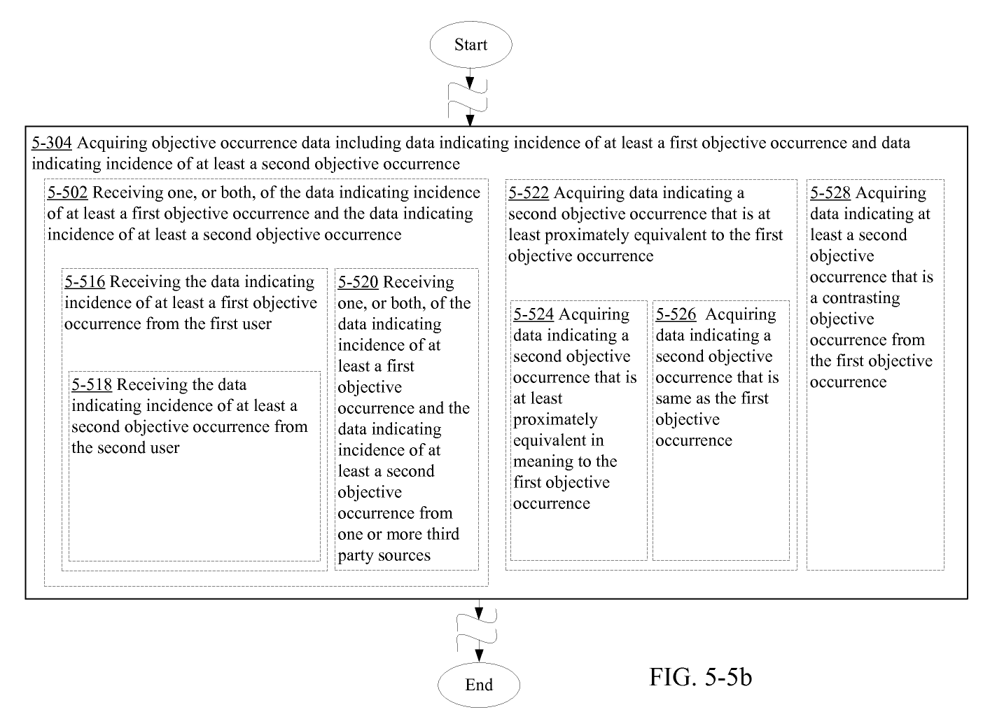

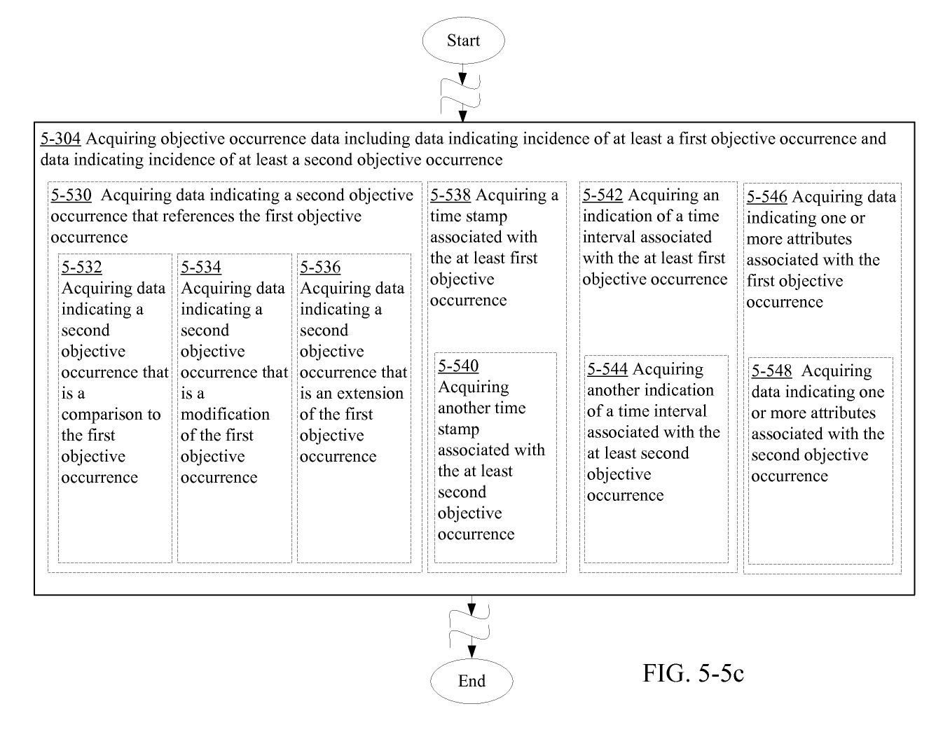

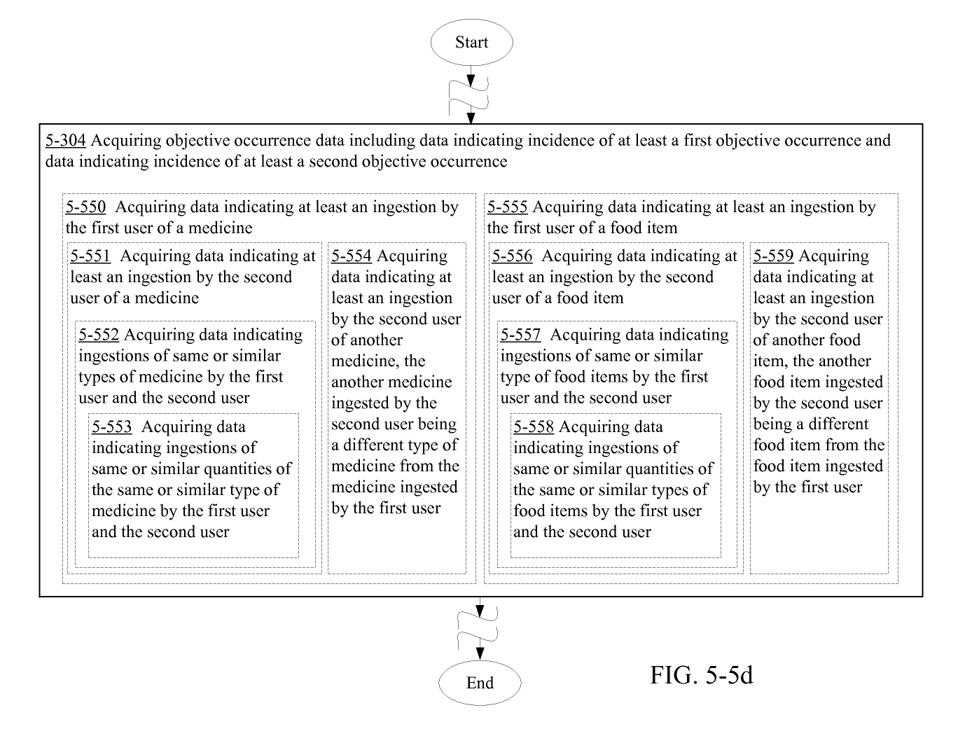

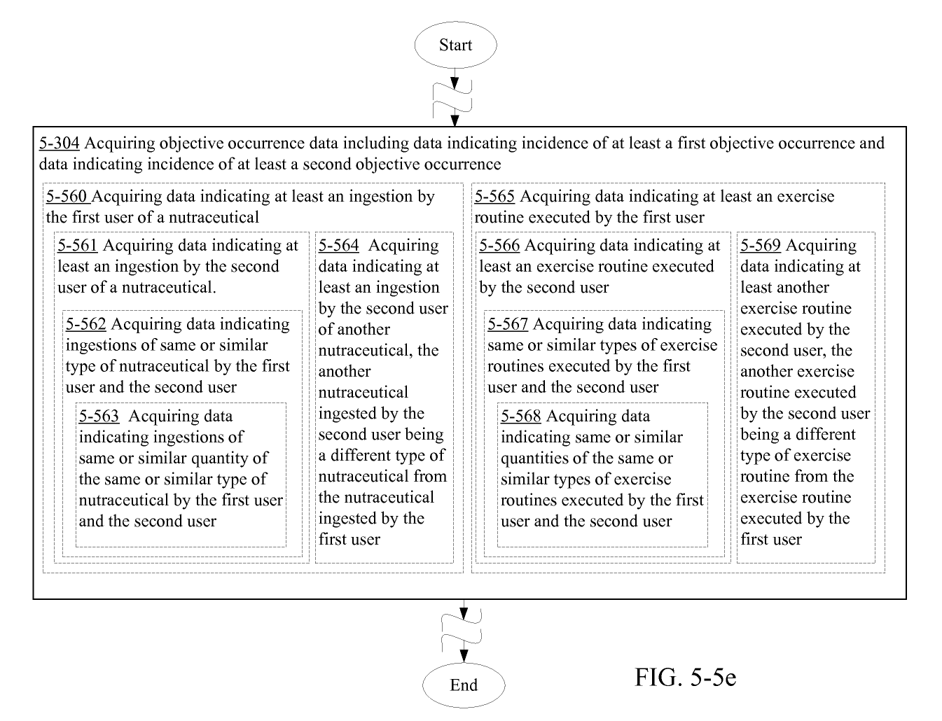

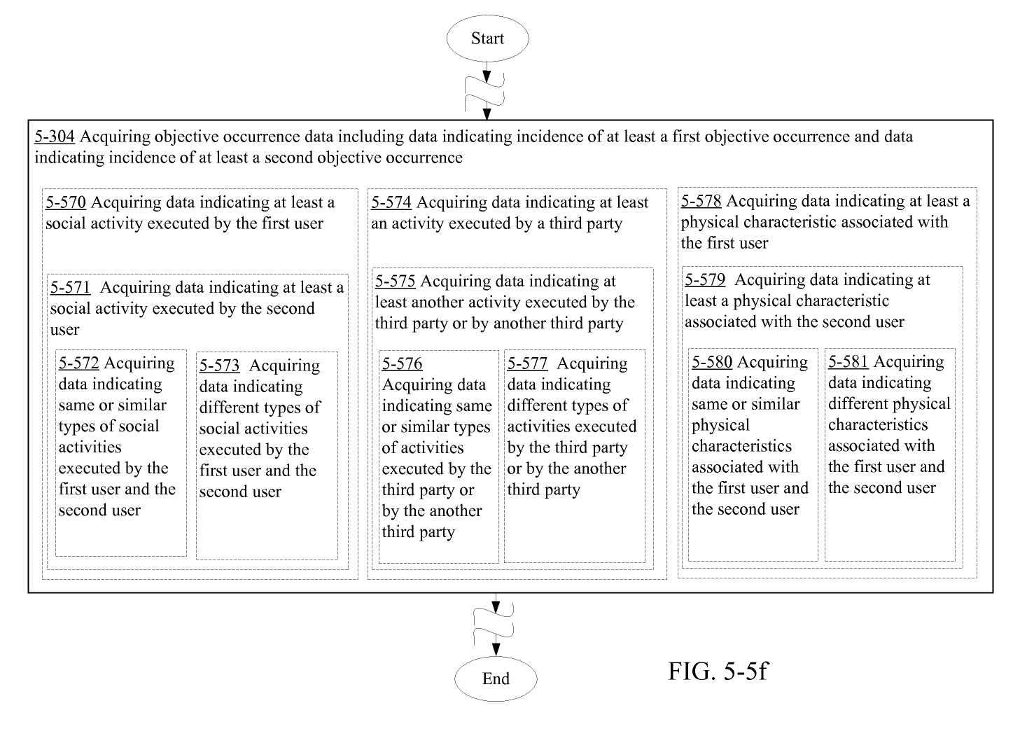

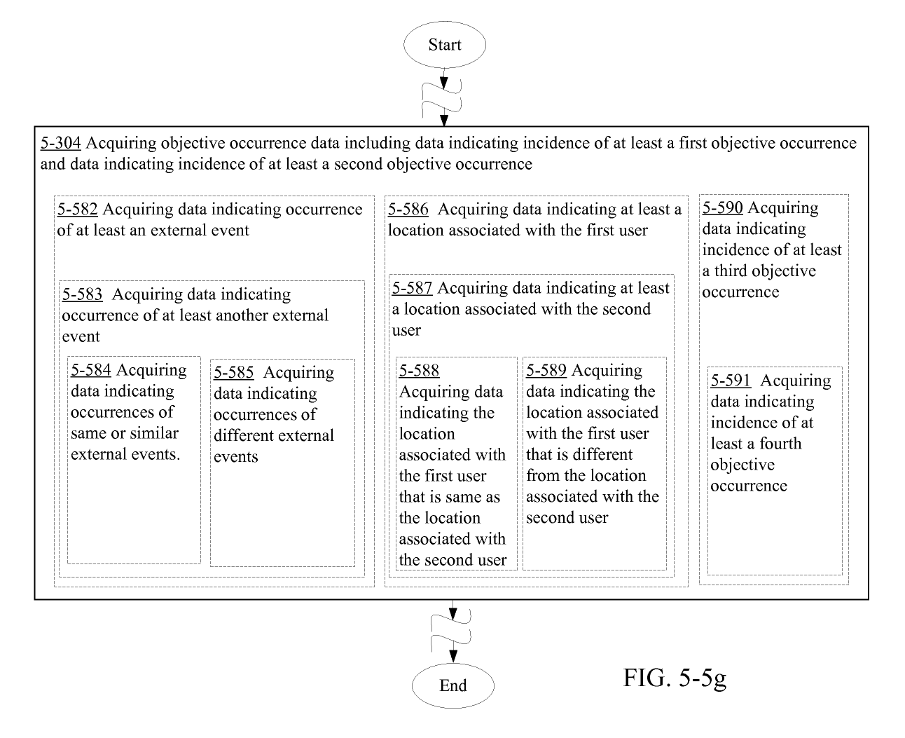

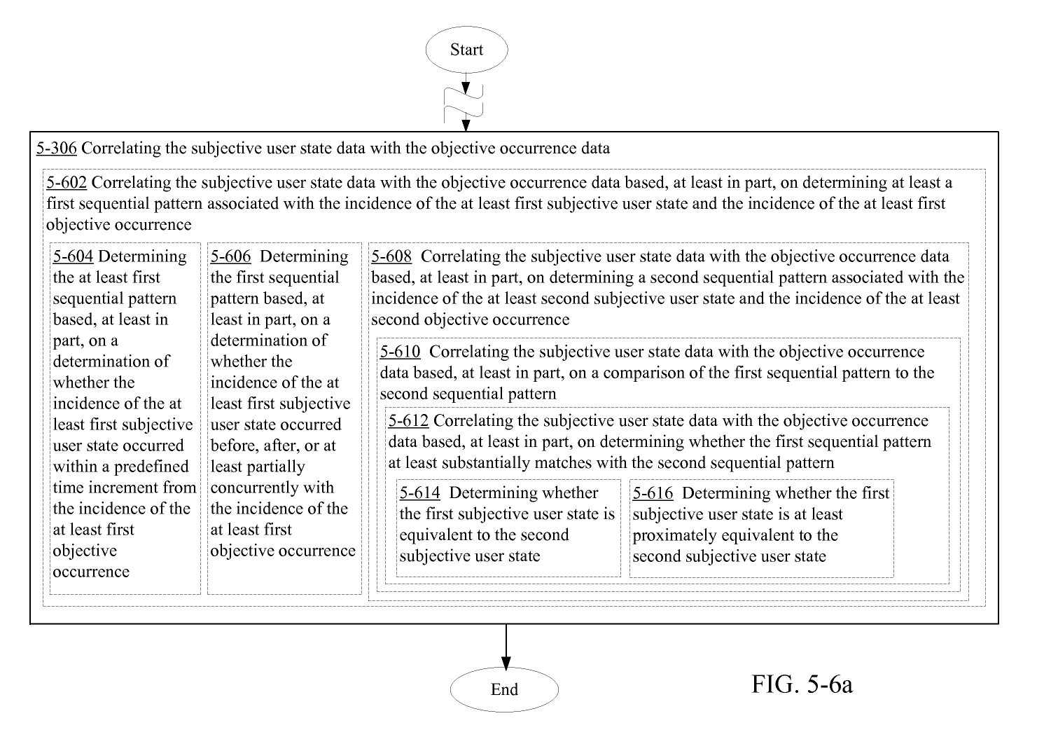

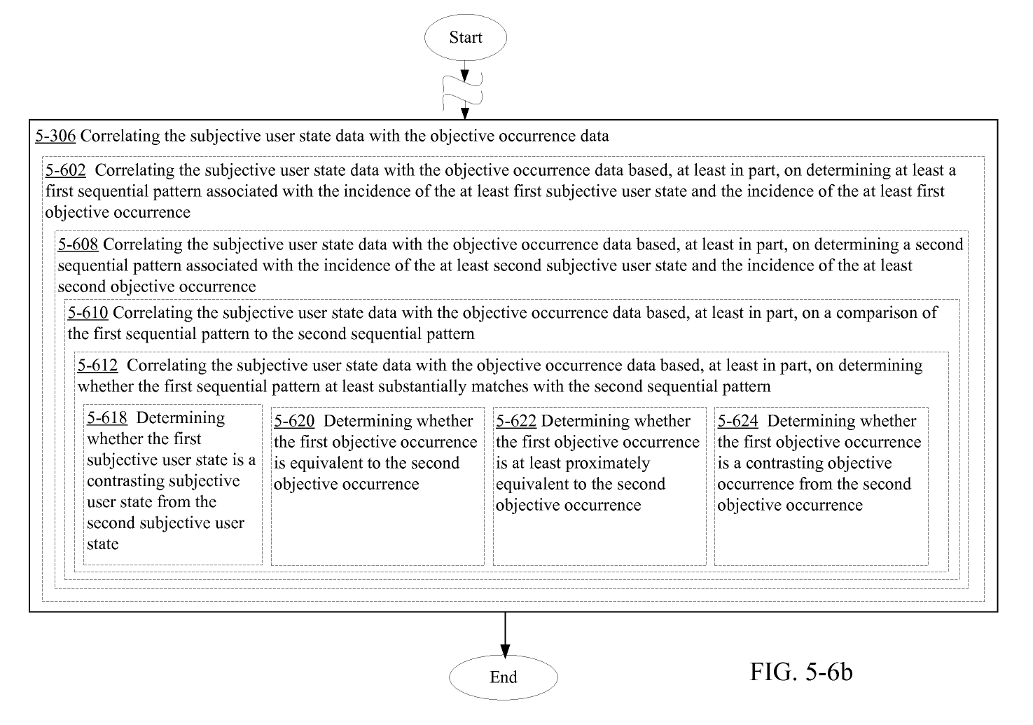

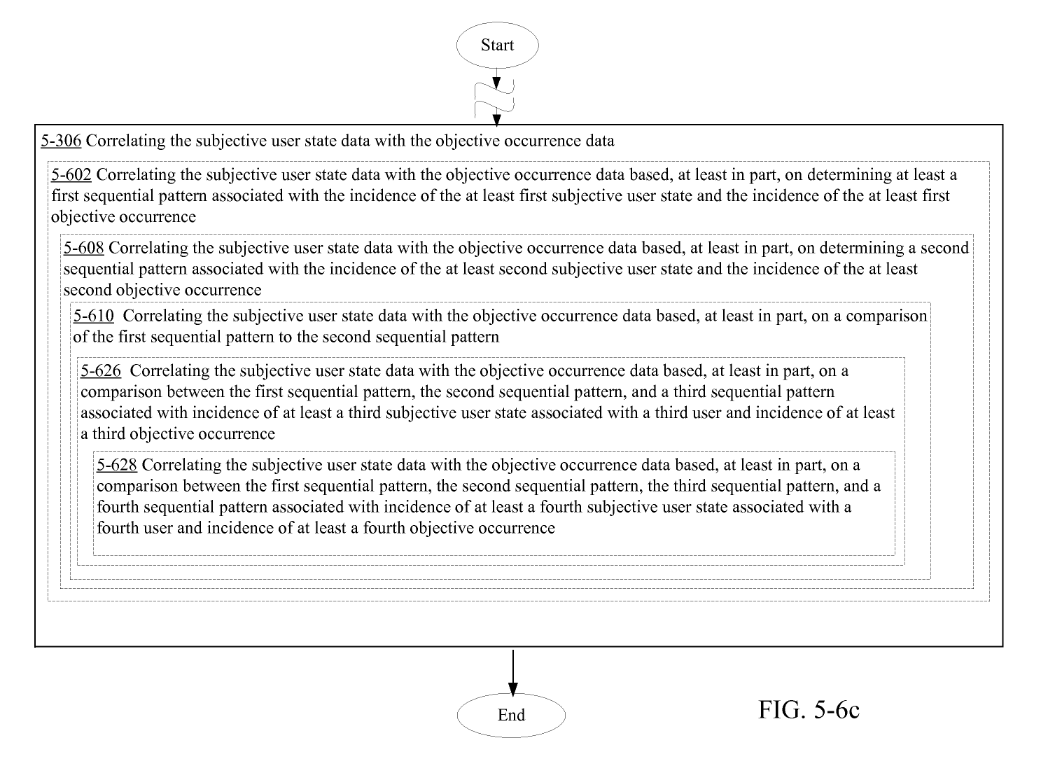

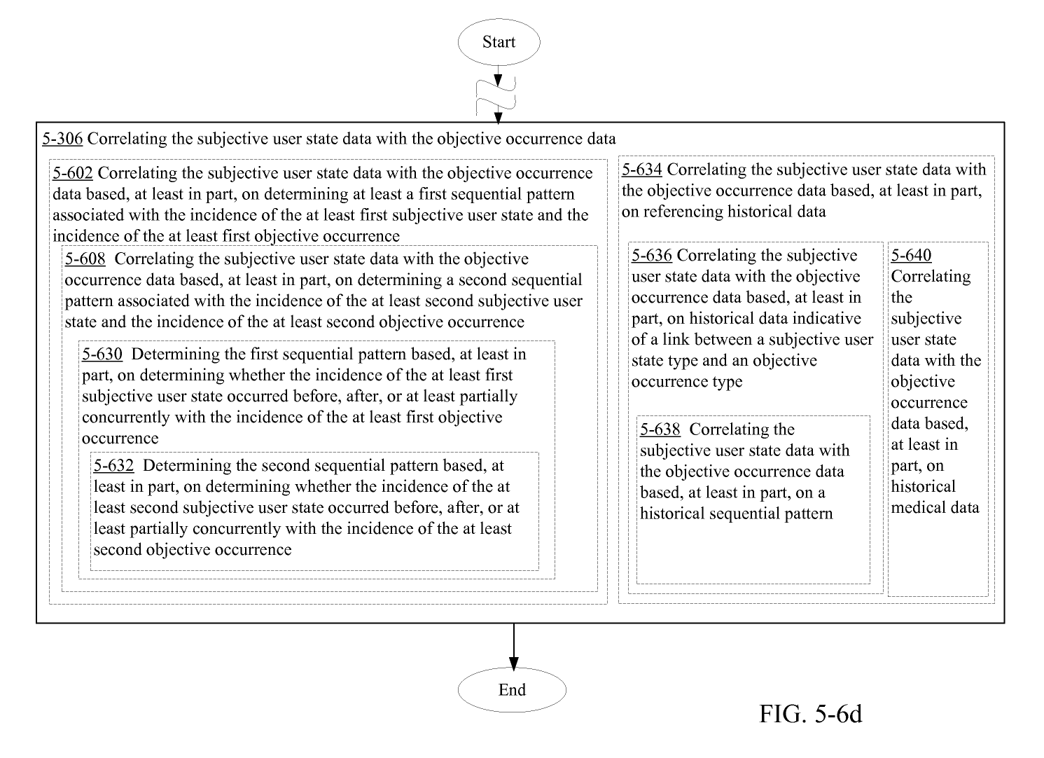

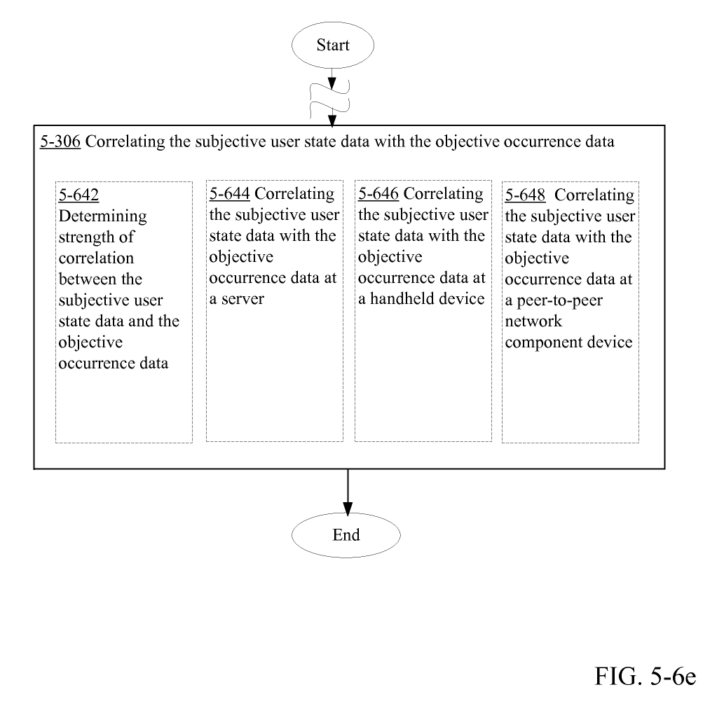

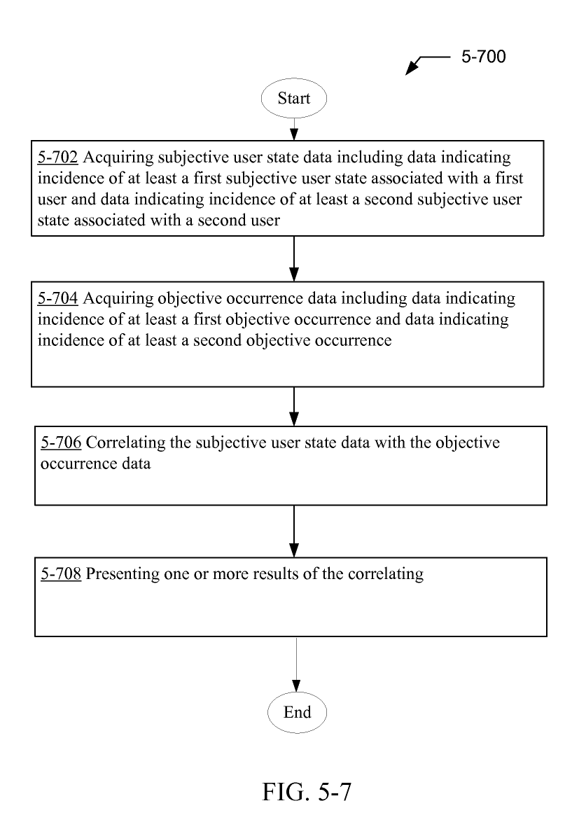

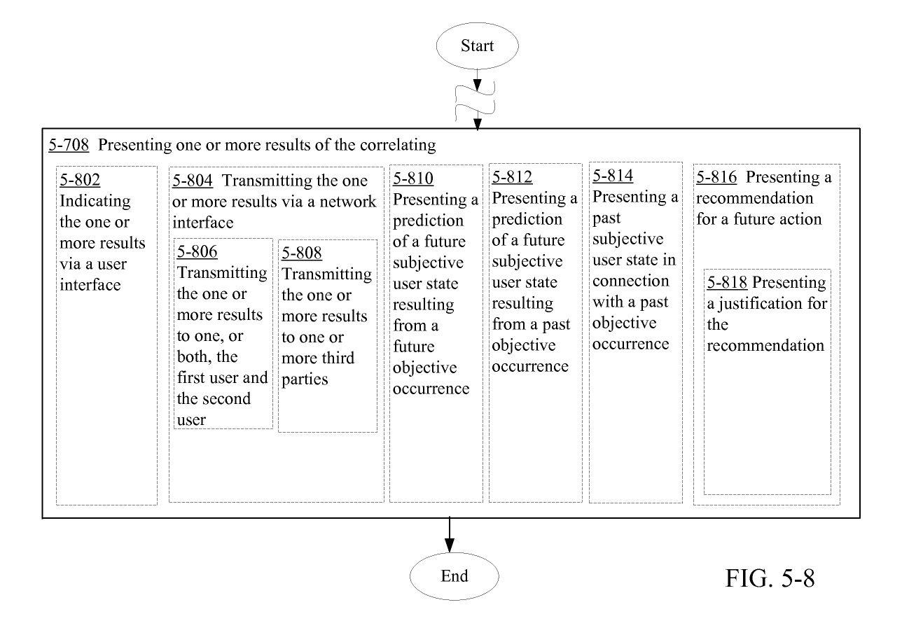

FIG. 4-5a is a high-level logic flowchart of a process depicting alternate implementations of the subjective user state data solicitation operation 4-304 of FIG. 4-3.

FIG. 4-5b is a high-level logic flowchart of a process depicting alternate implementations of the subjective user state data solicitation operation 4-304 of FIG. 4-3.

FIG. 4-5c is a high-level logic flowchart of a process depicting alternate implementations of the subjective user state data solicitation operation 4-304 of FIG. 4-3.

FIG. 4-5d is a high-level logic flowchart of a process depicting alternate implementations of the subjective user state data solicitation operation 4-304 of FIG. 4-3.

FIG. 4-6a is a high-level logic flowchart of a process depicting alternate implementations of the subjective user state data acquisition operation 4-306 of FIG. 4-3.

FIG. 4-6b is a high-level logic flowchart of a process depicting alternate implementations of the subjective user state data acquisition operation 4-306 of FIG. 4-3.

FIG. 4-6c is a high-level logic flowchart of a process depicting alternate implementations of the subjective user state data acquisition operation 4-306 of FIG. 4-3.

FIG. 4-7a is a high-level logic flowchart of a process depicting alternate implementations of the correlation operation 4-308 of FIG. 4-3.

FIG. 4-7b is a high-level logic flowchart of a process depicting alternate implementations of the correlation operation 4-308 of FIG. 4-3.

FIG. 4-8 is a high-level logic flowchart of another process.

FIG. 4-9 is a high-level logic flowchart of a process depicting alternate implementations of the presentation operation 4-810 of FIG. 4-8.

FIGS. 5-1a and 5-1b show a high-level block diagram of a network device operating in a network environment.

FIG. 5-2a shows another perspective of the subjective user state data acquisition module 5-102 of the computing device 5-10 of FIG. 5-1b.

FIG. 5-2b shows another perspective of the objective occurrence data acquisition module 5-104 of the computing device 5-10 of FIG. 5-1b.

FIG. 5-2c shows another perspective of the correlation module 5-106 of the computing device 5-10 of FIG. 5-1b.

FIG. 5-2d shows another perspective of the presentation module 5-108 of the computing device 5-10 of FIG. 5-1b.

FIG. 5-2e shows another perspective of the one or more applications 5-126 of the computing device 5-10 of FIG. 5-1b.

FIG. 5-3 is a high-level logic flowchart of a process.

FIG. 5-4a is a high-level logic flowchart of a process depicting alternate implementations of the subjective user state data acquisition operation 5-302 of FIG. 5-3.

FIG. 5-4b is a high-level logic flowchart of a process depicting alternate implementations of the subjective user state data acquisition operation 5-302 of FIG. 5-3.

FIG. 5-4c is a high-level logic flowchart of a process depicting alternate implementations of the subjective user state data acquisition operation 5-302 of FIG. 5-3.

FIG. 5-4d is a high-level logic flowchart of a process depicting alternate implementations of the subjective user state data acquisition operation 5-302 of FIG. 5-3.

FIG. 5-4e is a high-level logic flowchart of a process depicting alternate implementations of the subjective user state data acquisition operation 5-302 of FIG. 5-3.

FIG. 5-4f is a high-level logic flowchart of a process depicting alternate implementations of the subjective user state data acquisition operation 5-302 of FIG. 5-3.

FIG. 5-5a is a high-level logic flowchart of a process depicting alternate implementations of the objective occurrence data acquisition operation 5-304 of FIG. 5-3.

FIG. 5-5b is a high-level logic flowchart of a process depicting alternate implementations of the objective occurrence data acquisition operation 5-304 of FIG. 5-3.

FIG. 5-5c is a high-level logic flowchart of a process depicting alternate implementations of the objective occurrence data acquisition operation 5-304 of FIG. 5-3.

FIG. 5-5d is a high-level logic flowchart of a process depicting alternate implementations of the objective occurrence data acquisition operation 5-304 of FIG. 5-3.

FIG. 5-5e is a high-level logic flowchart of a process depicting alternate implementations of the objective occurrence data acquisition operation 5-304 of FIG. 5-3.

FIG. 5-5f is a high-level logic flowchart of a process depicting alternate implementations of the objective occurrence data acquisition operation 5-304 of FIG. 5-3.

FIG. 5-5g is a high-level logic flowchart of a process depicting alternate implementations of the objective occurrence data acquisition operation 5-304 of FIG. 5-3.

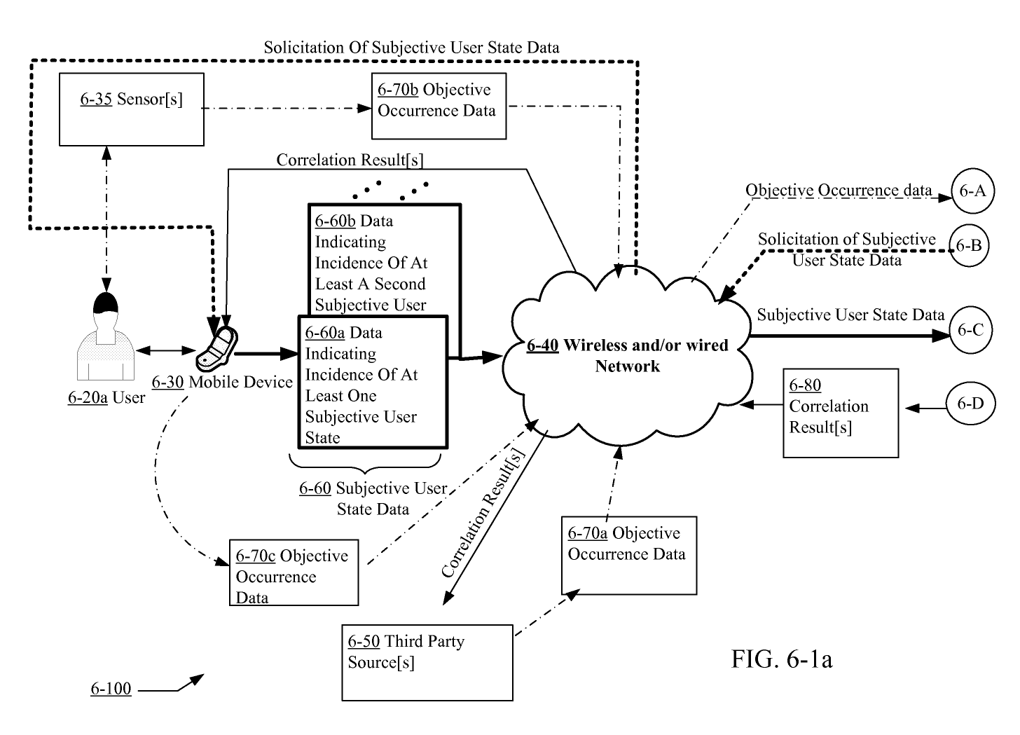

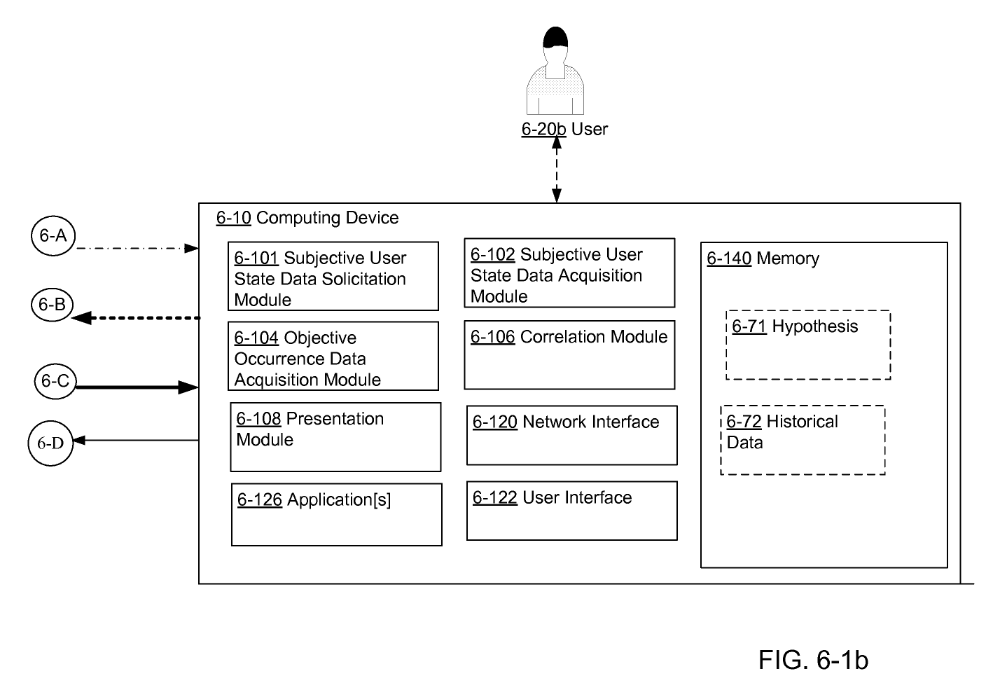

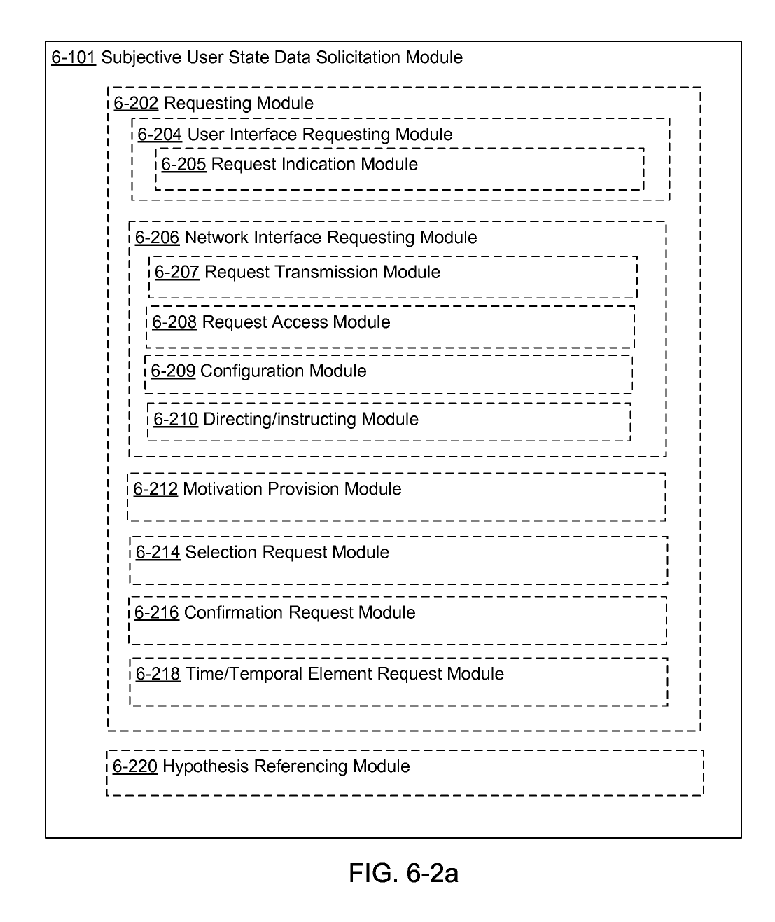

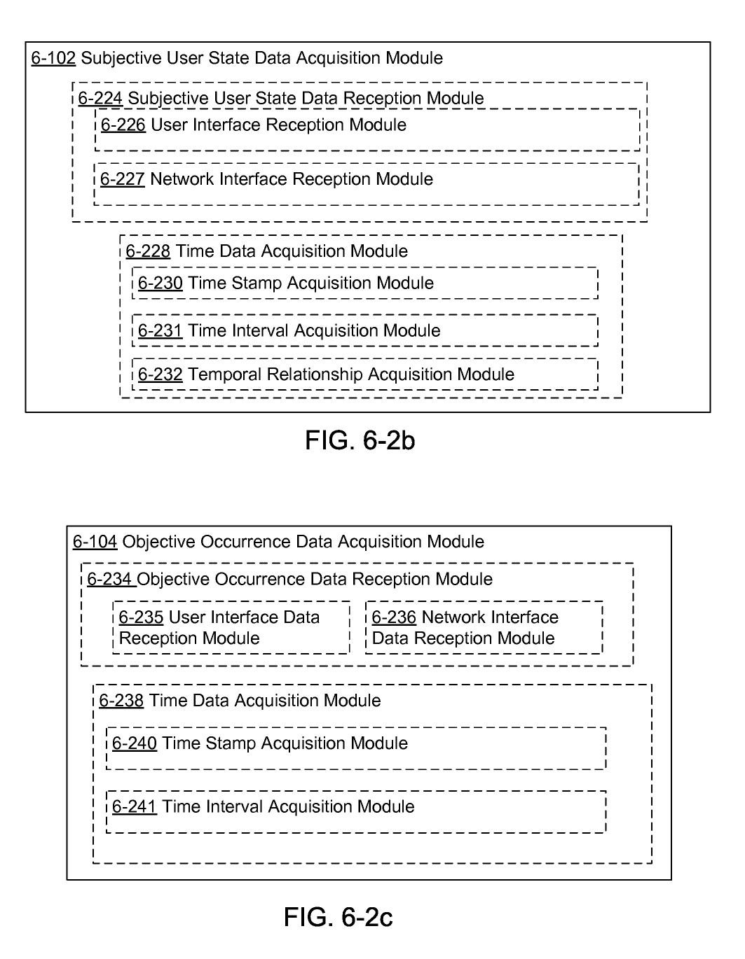

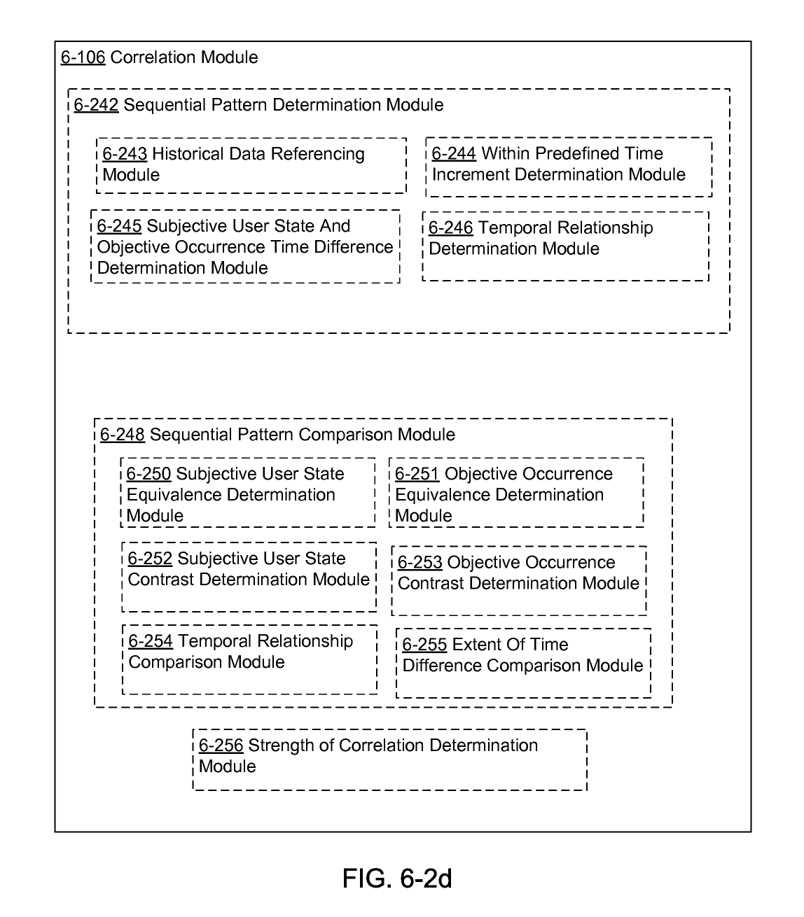

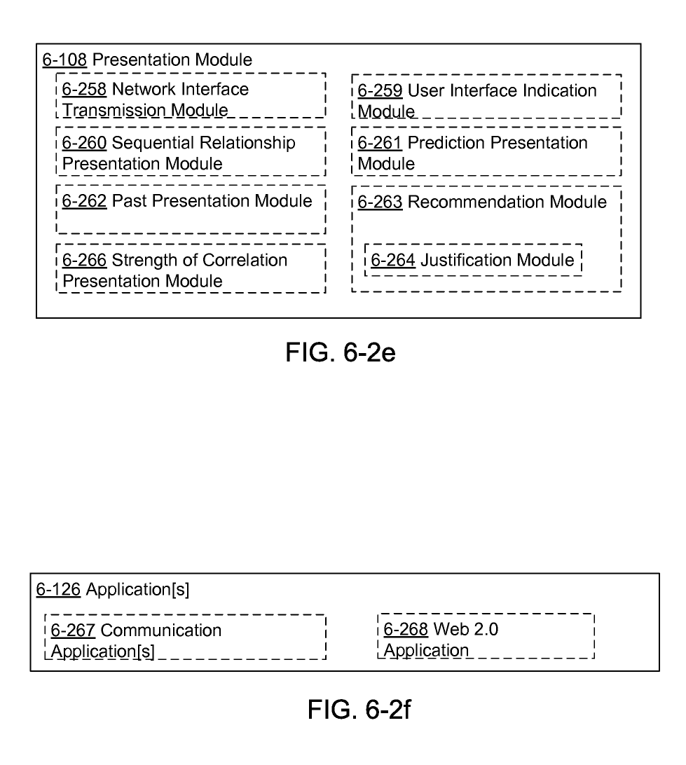

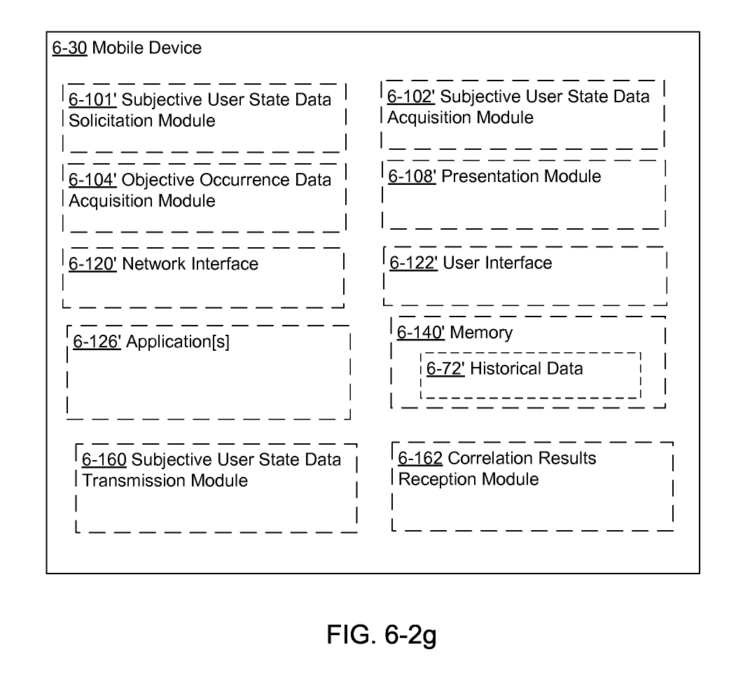

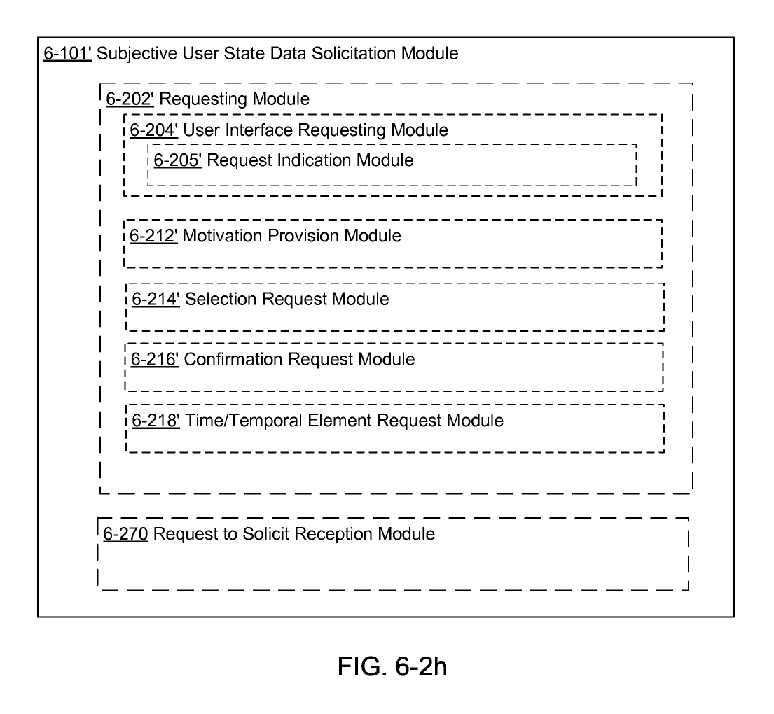

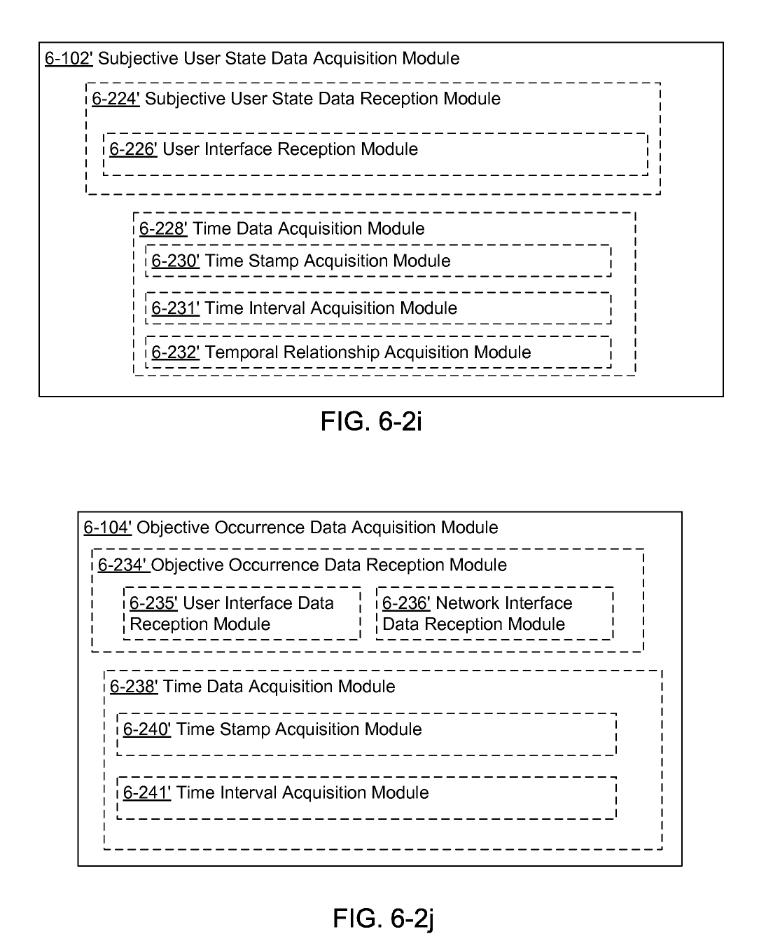

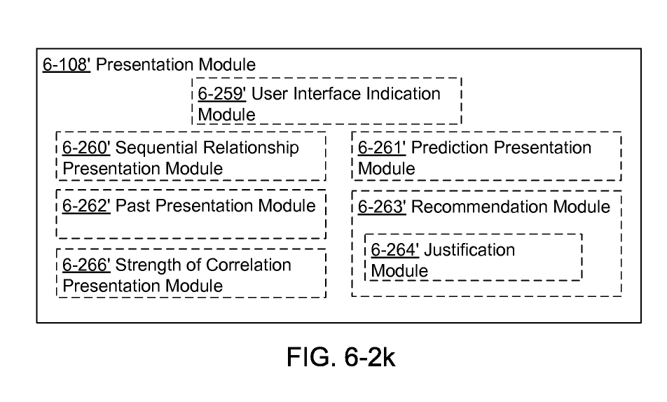

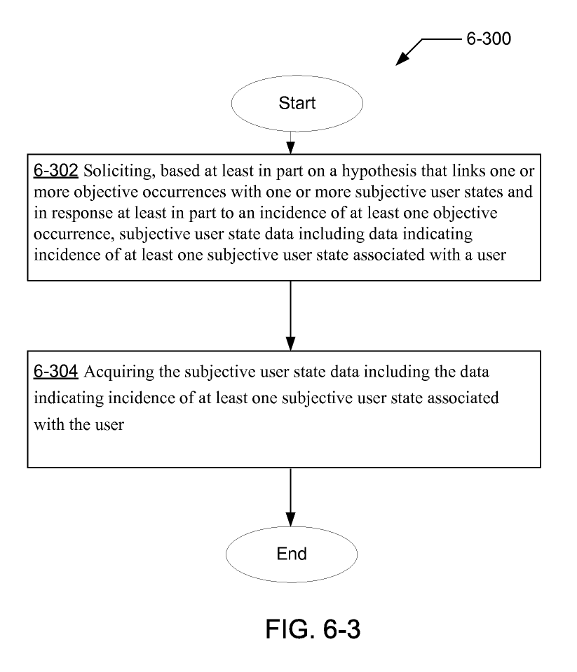

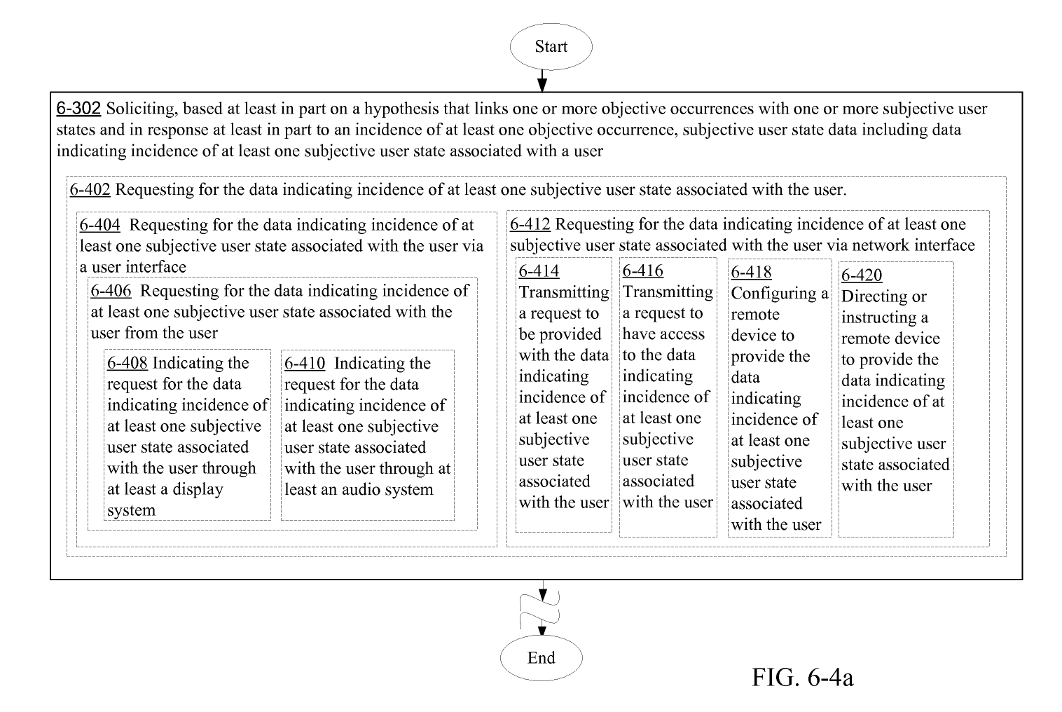

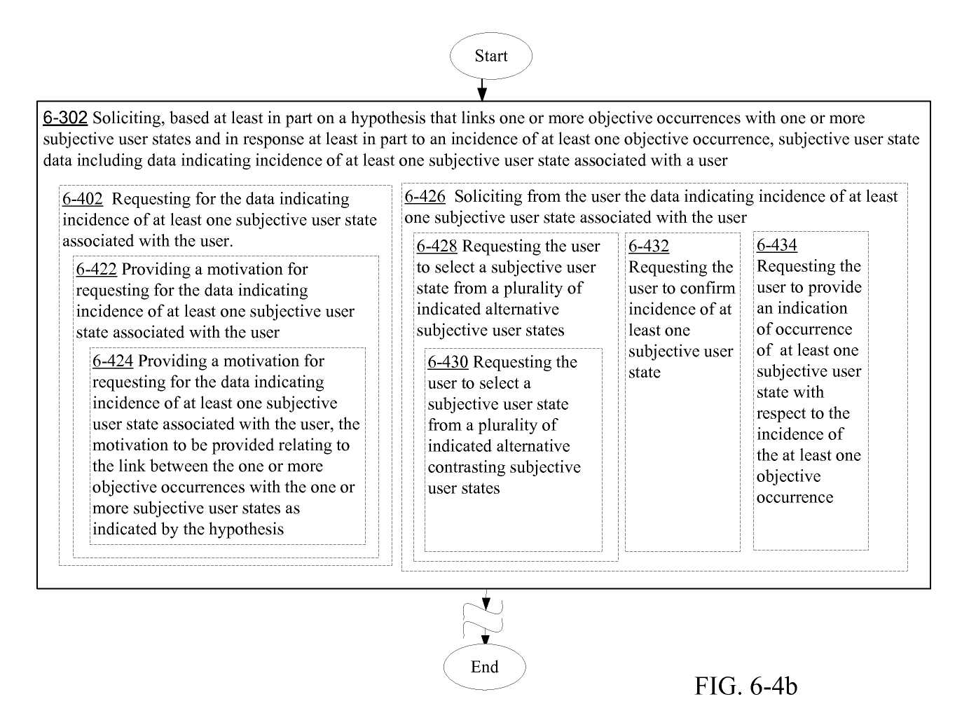

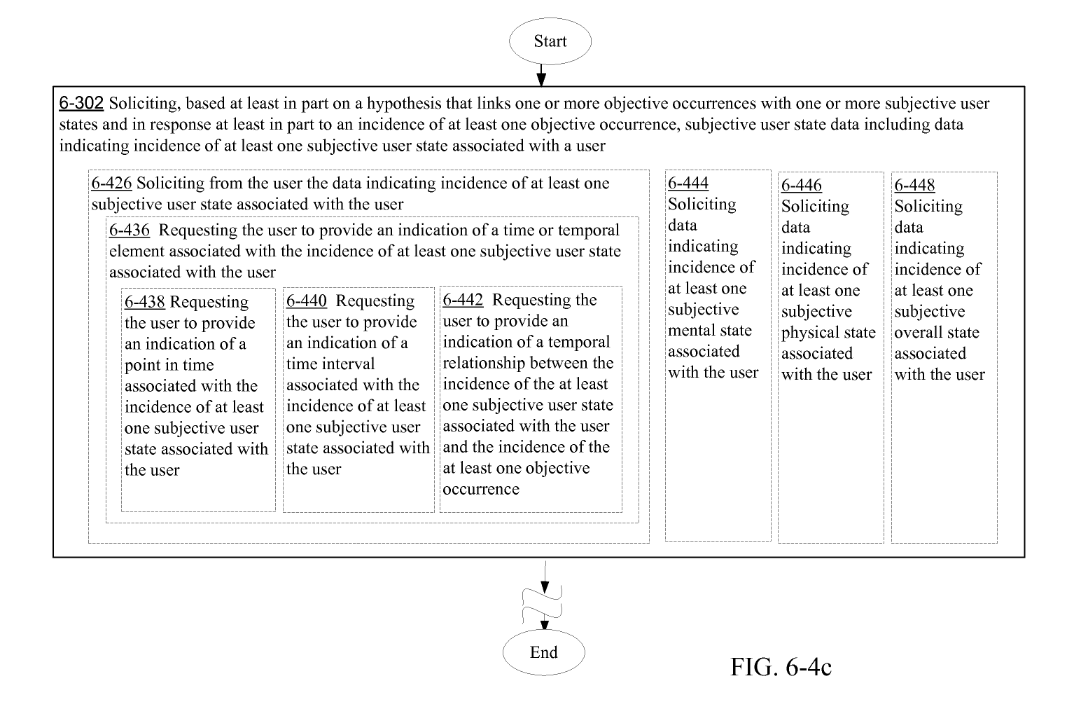

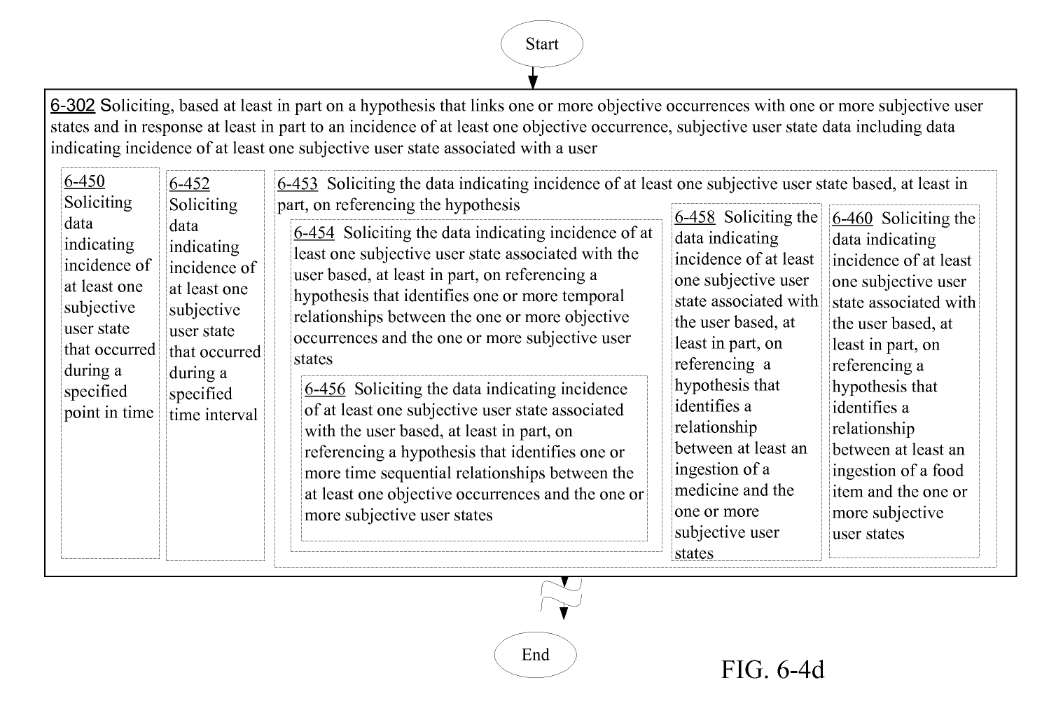

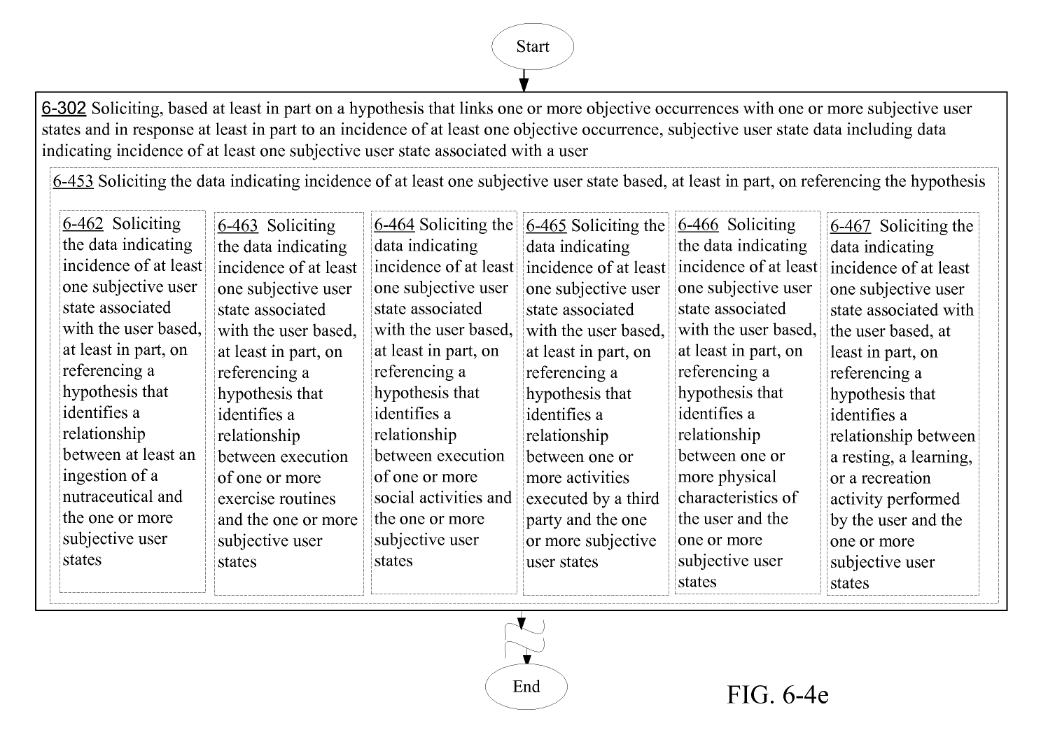

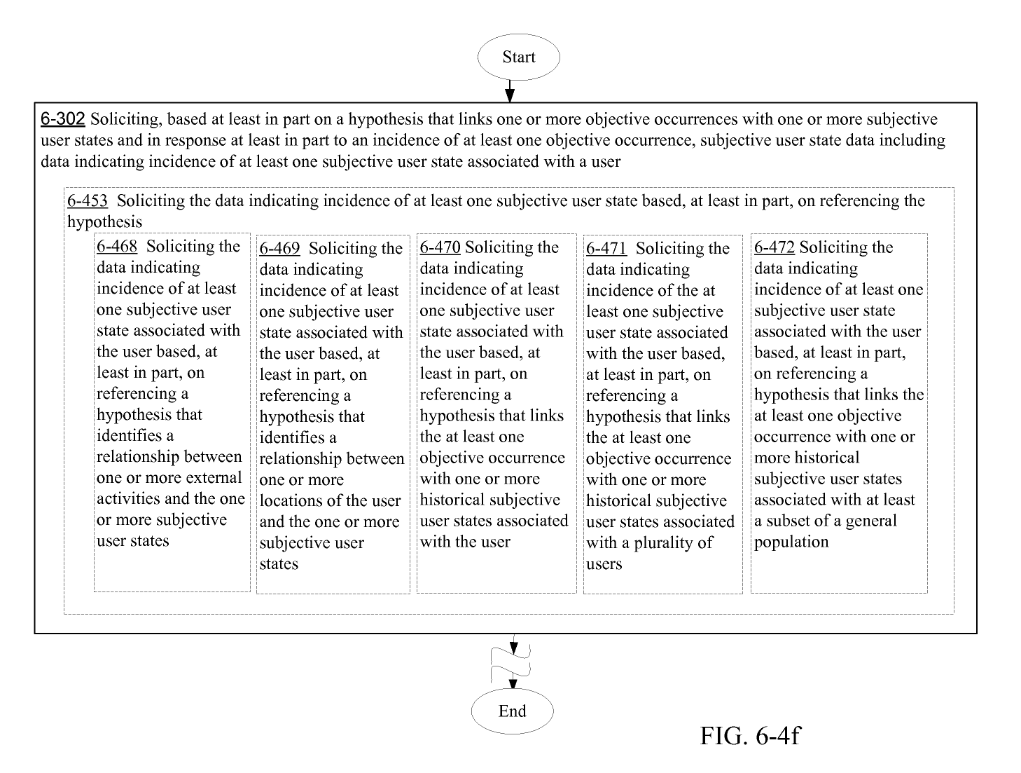

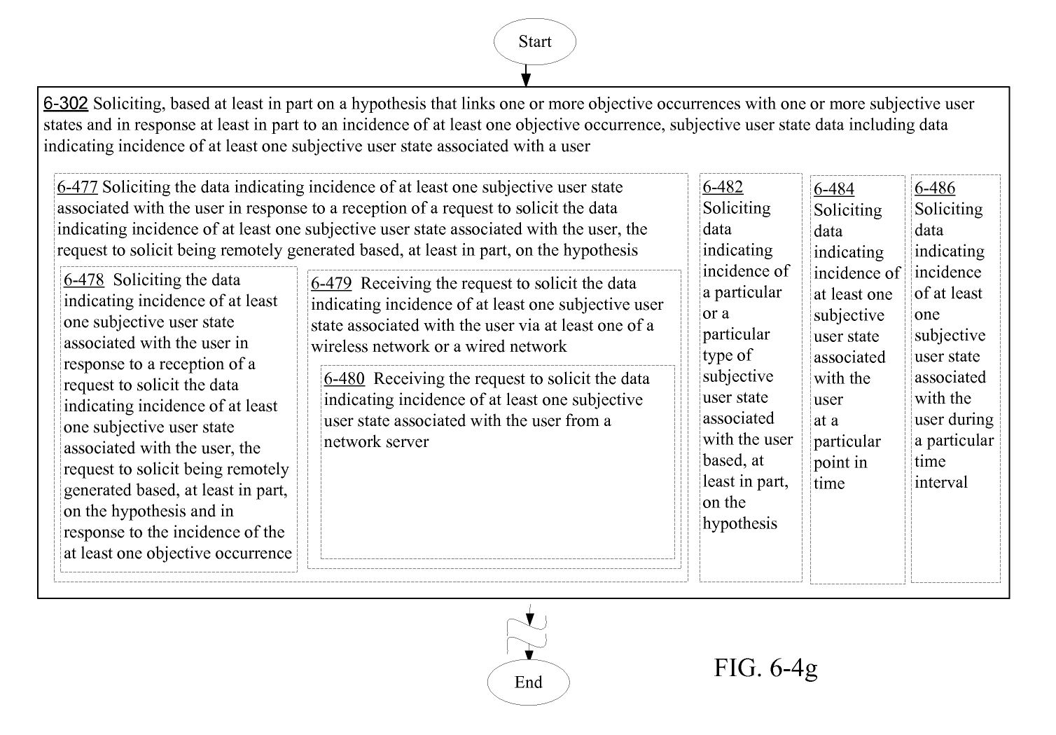

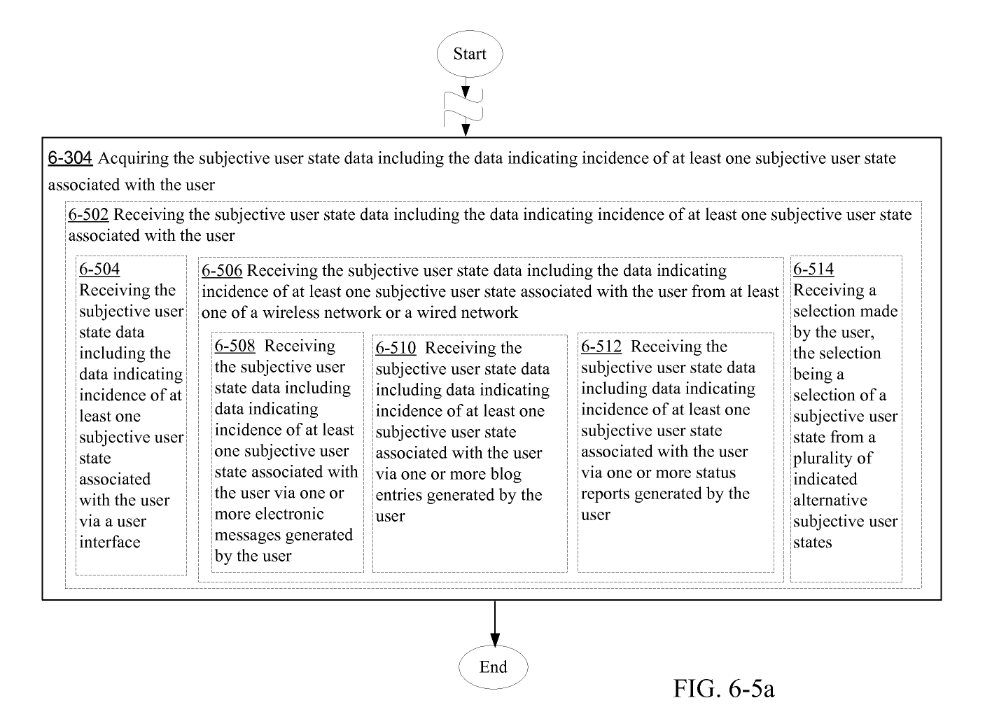

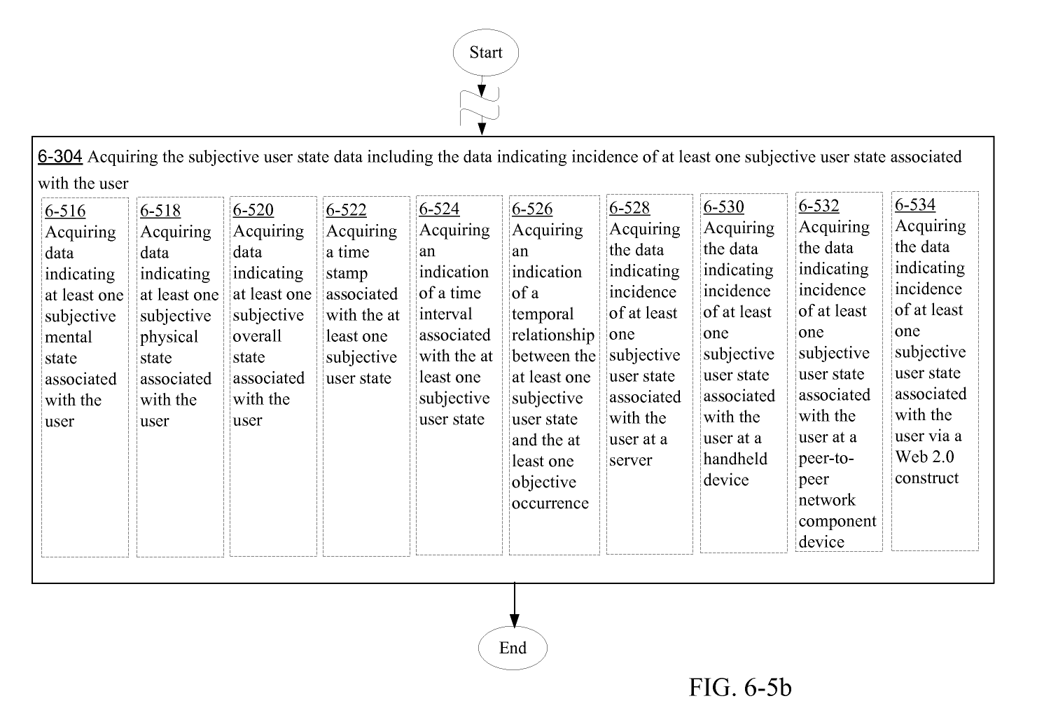

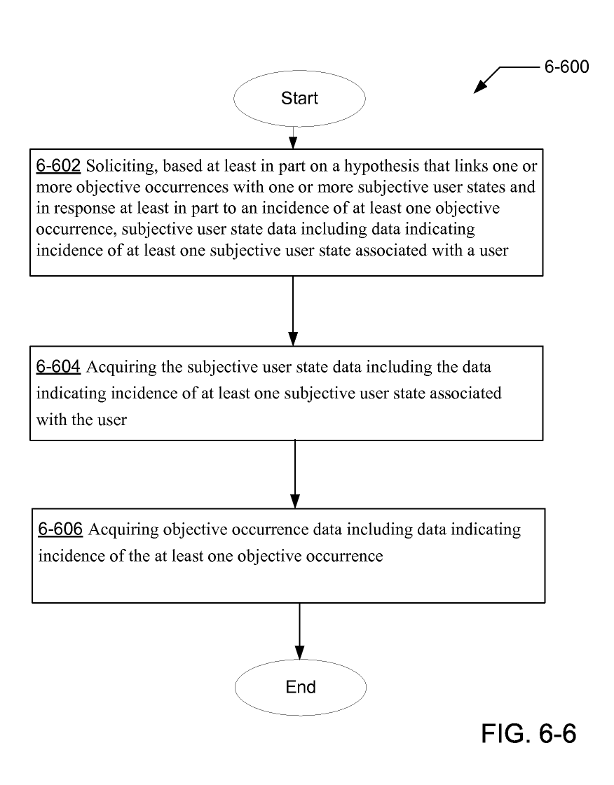

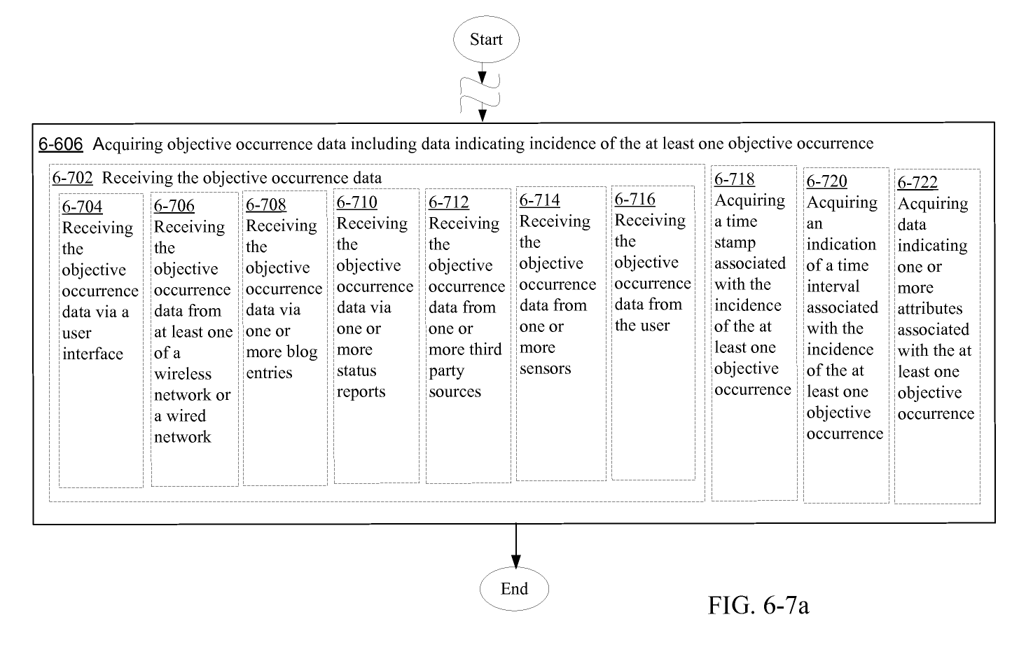

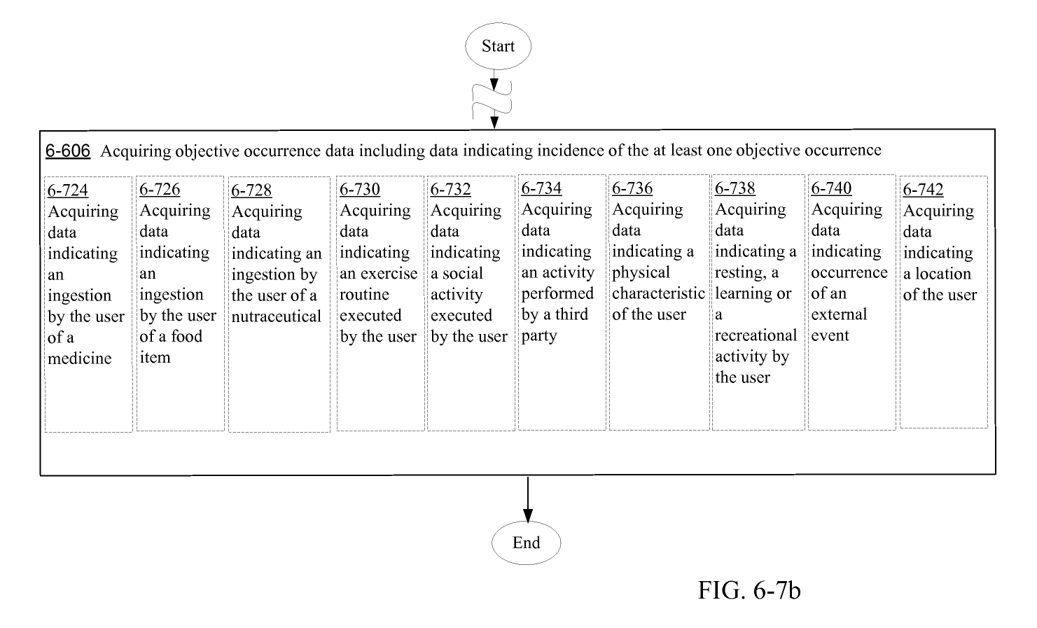

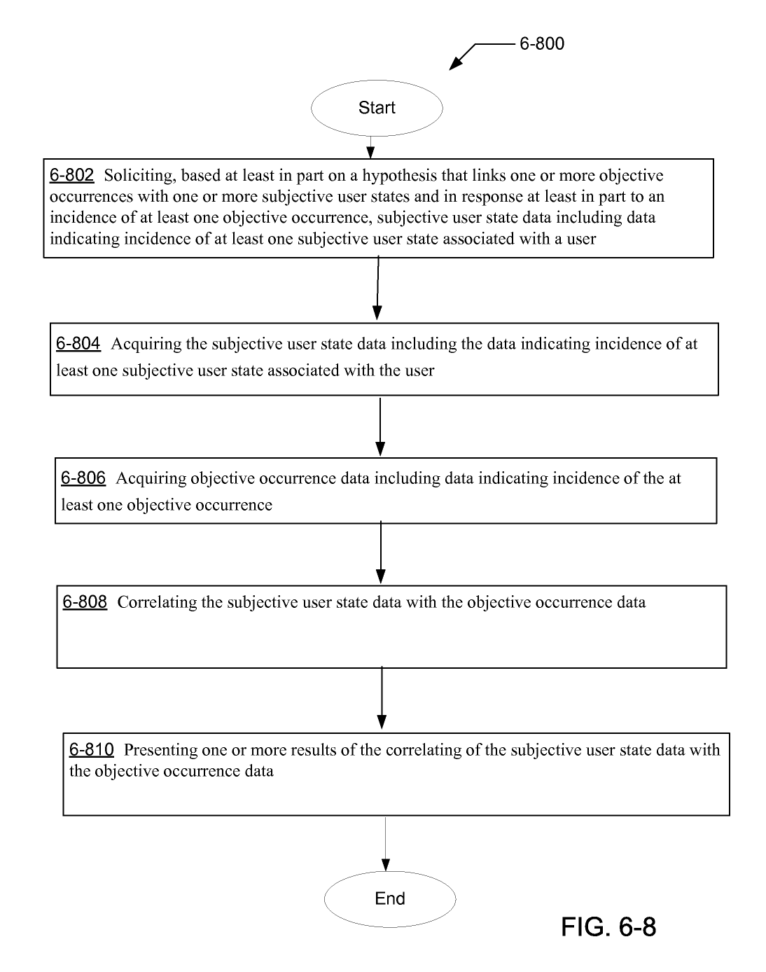

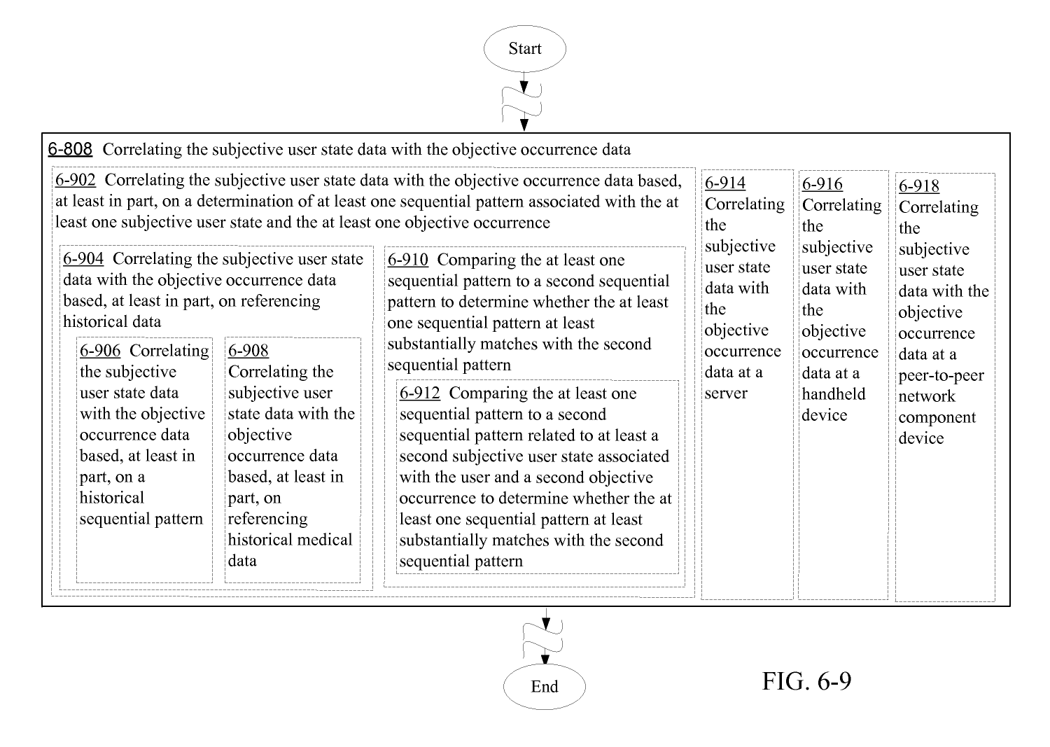

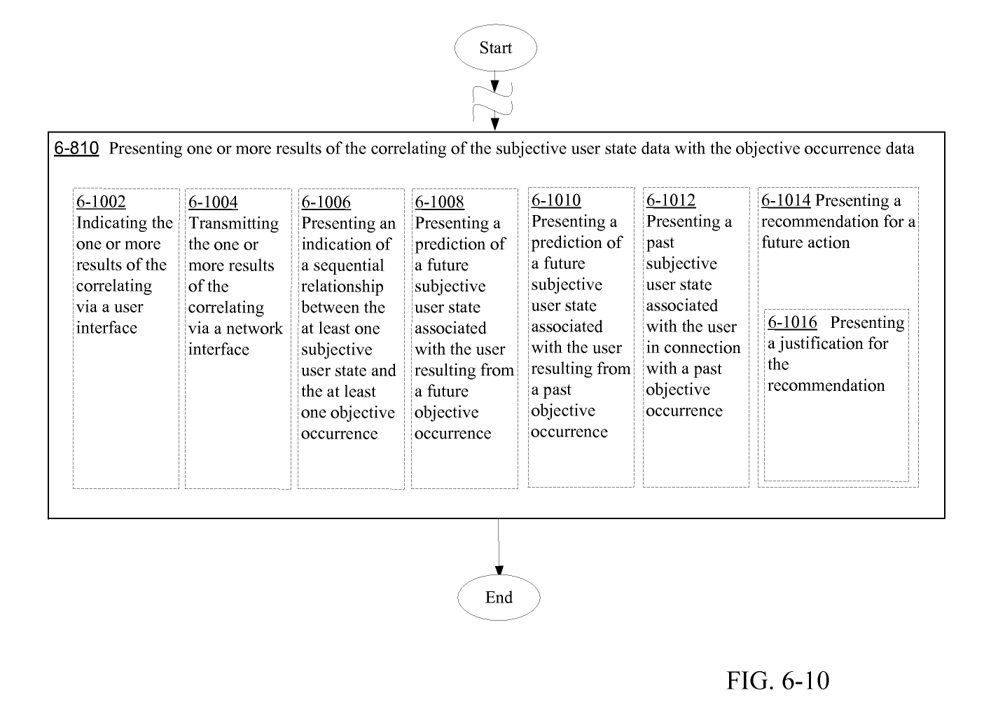

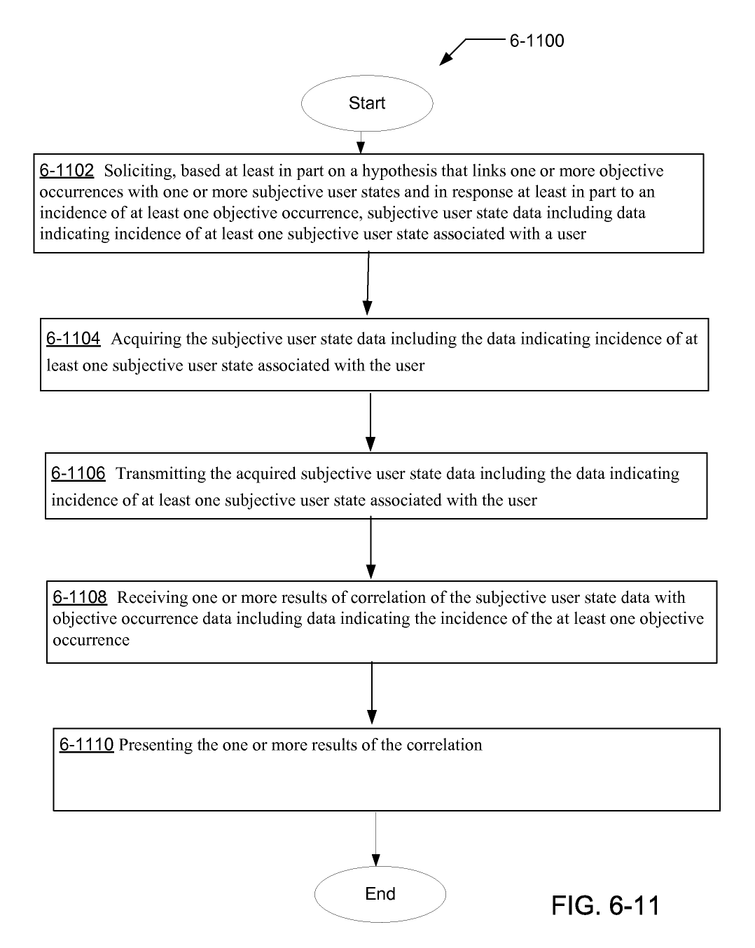

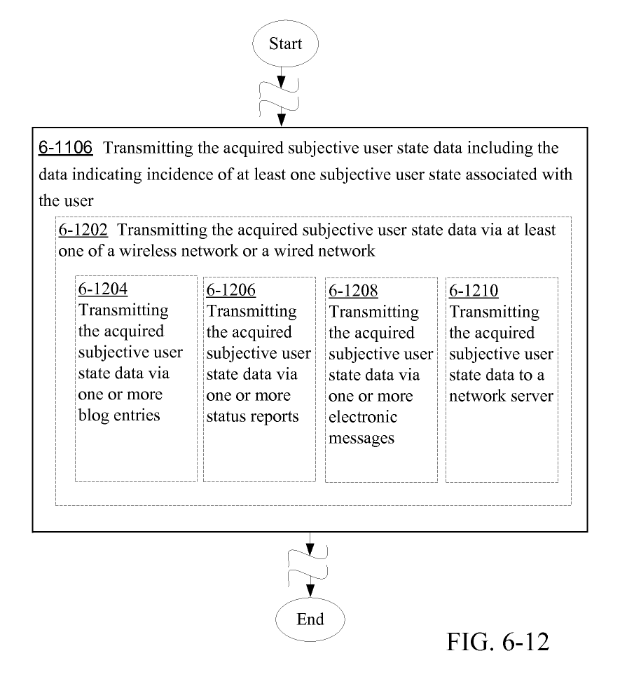

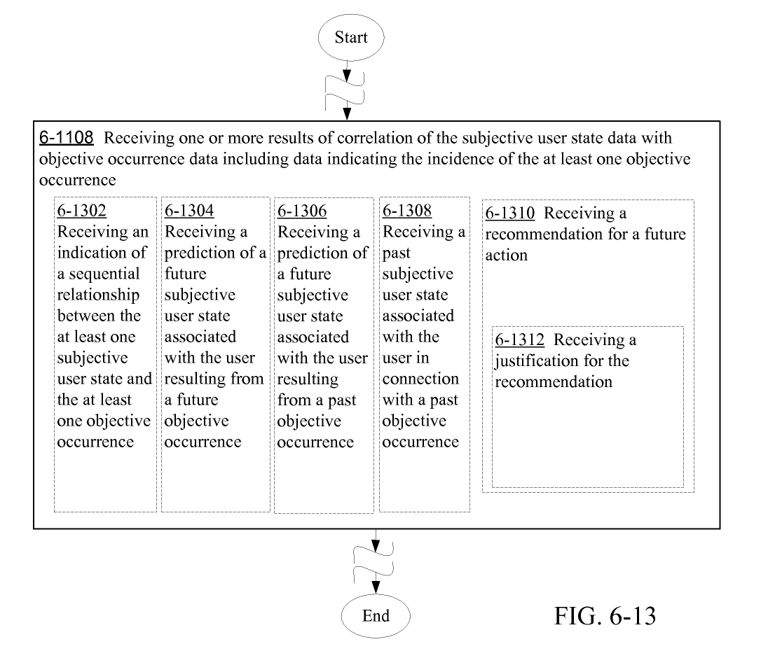

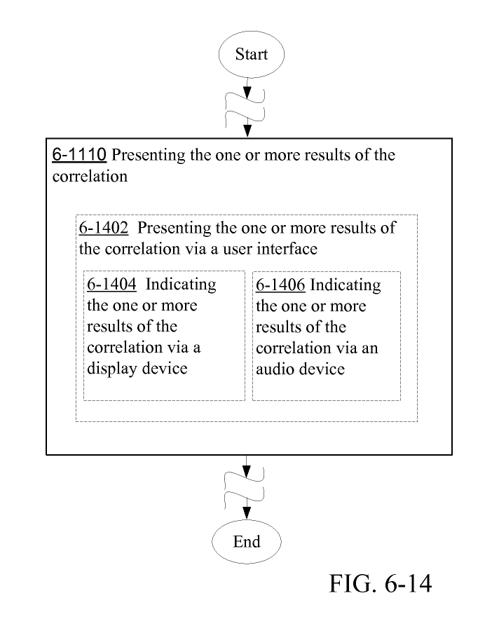

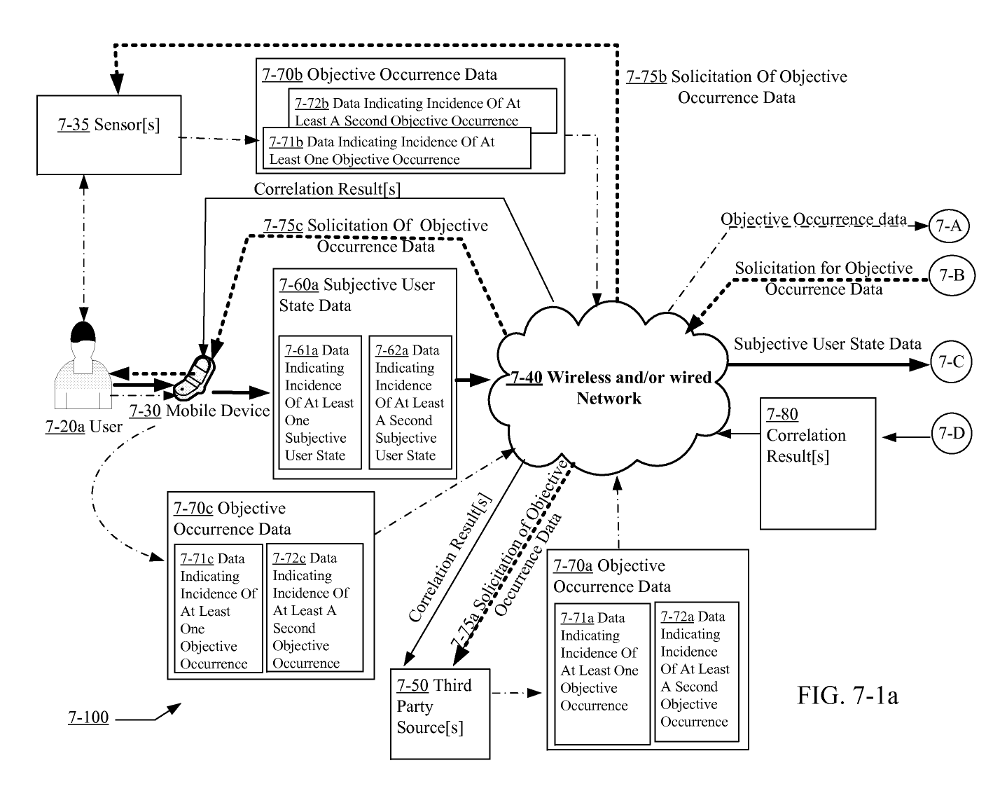

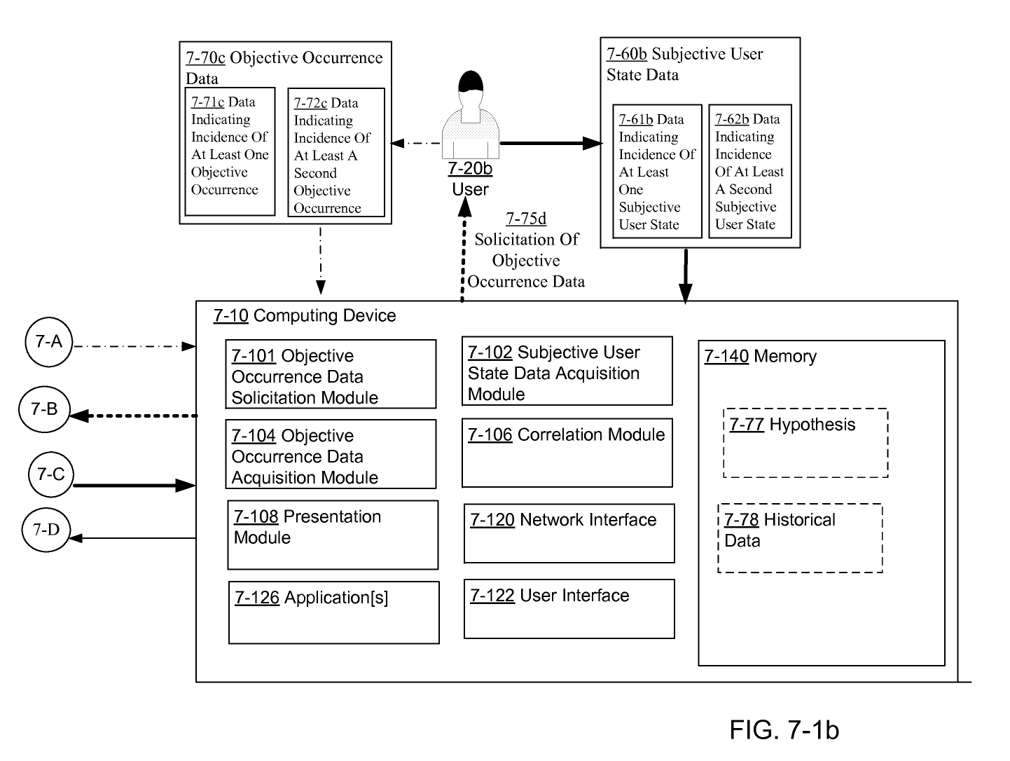

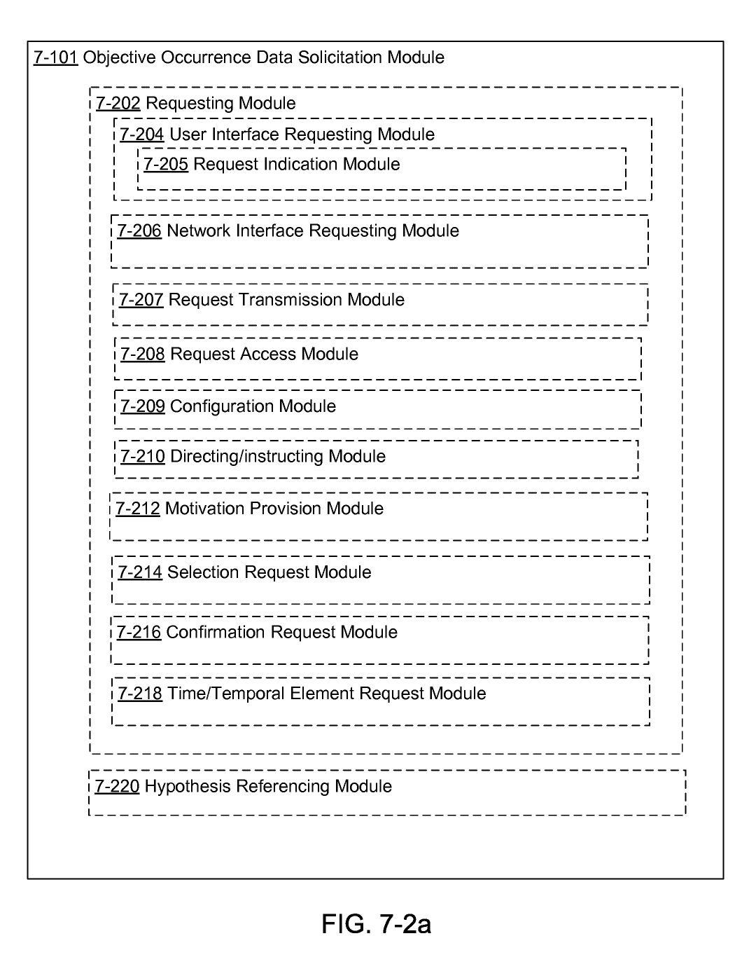

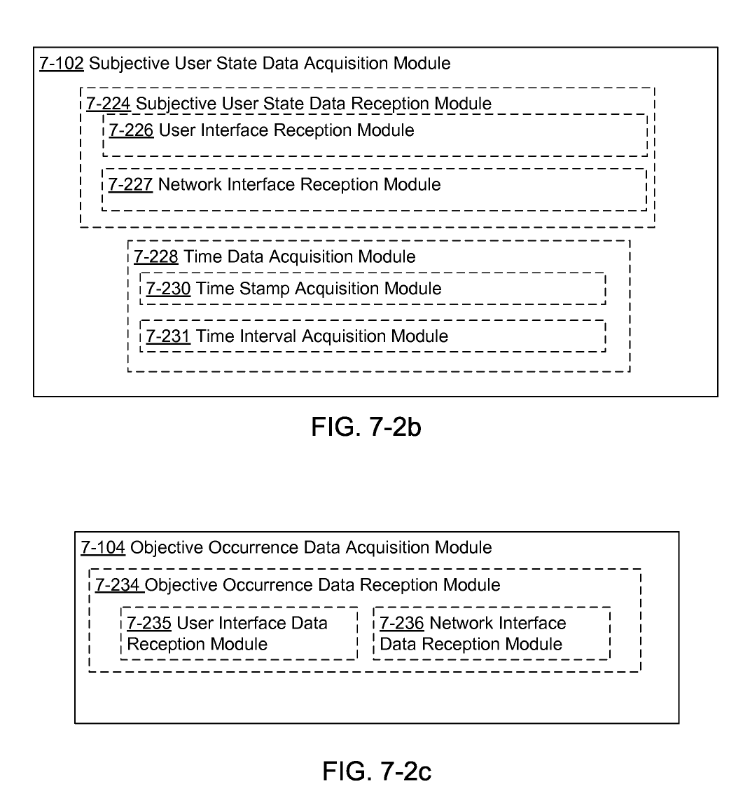

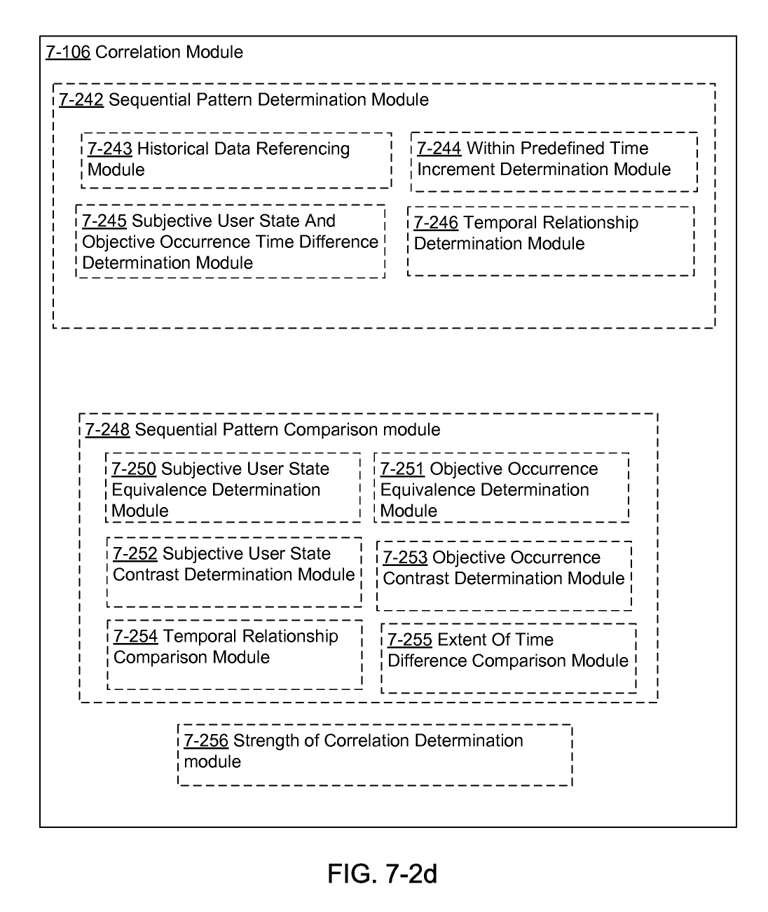

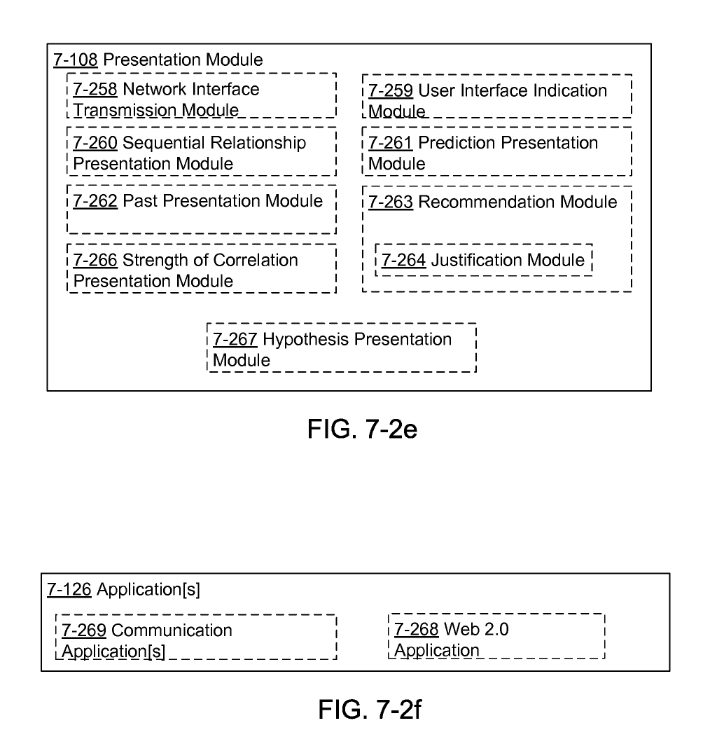

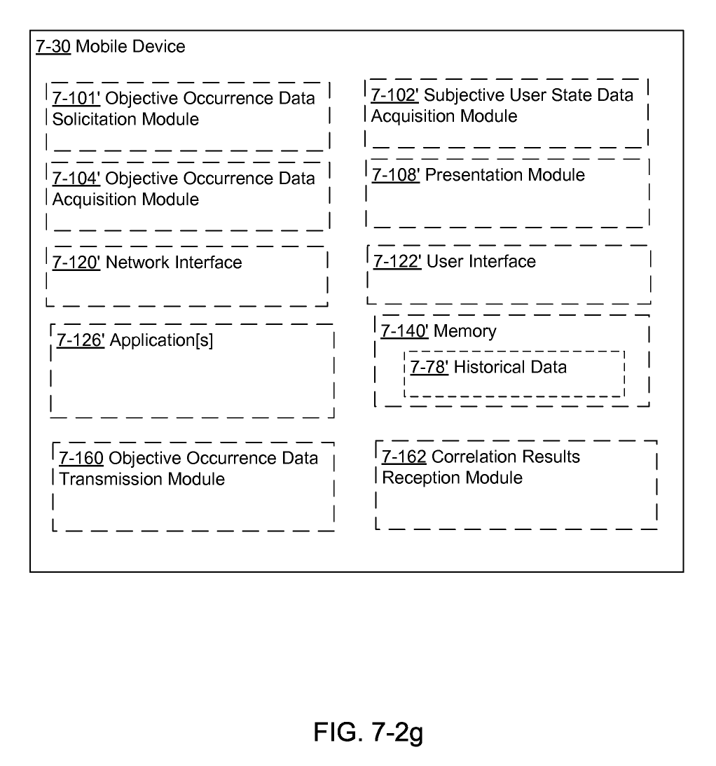

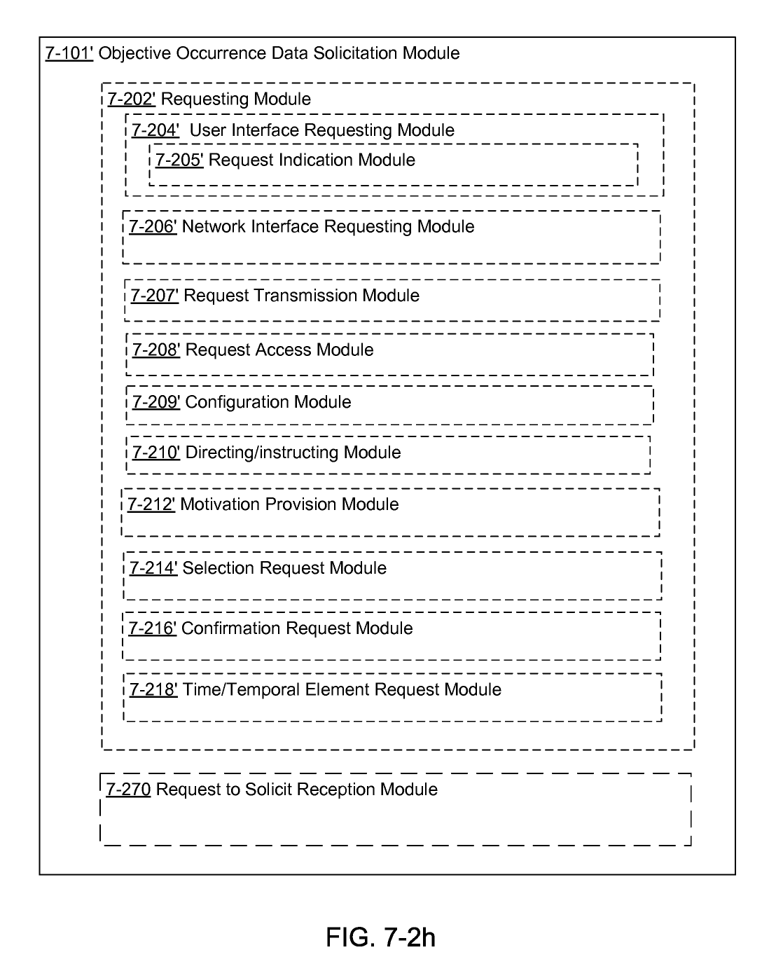

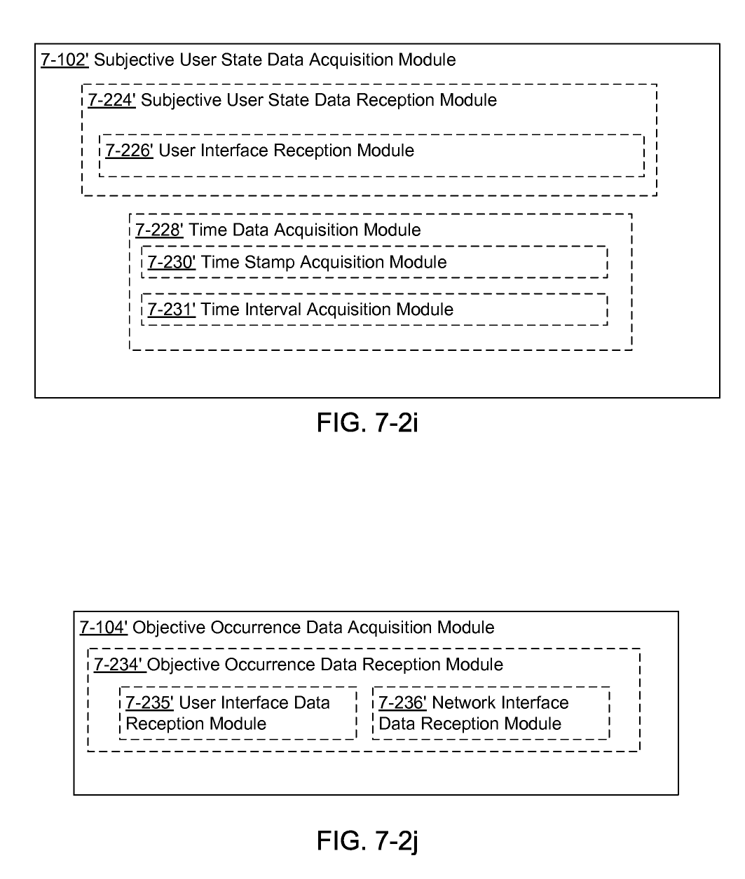

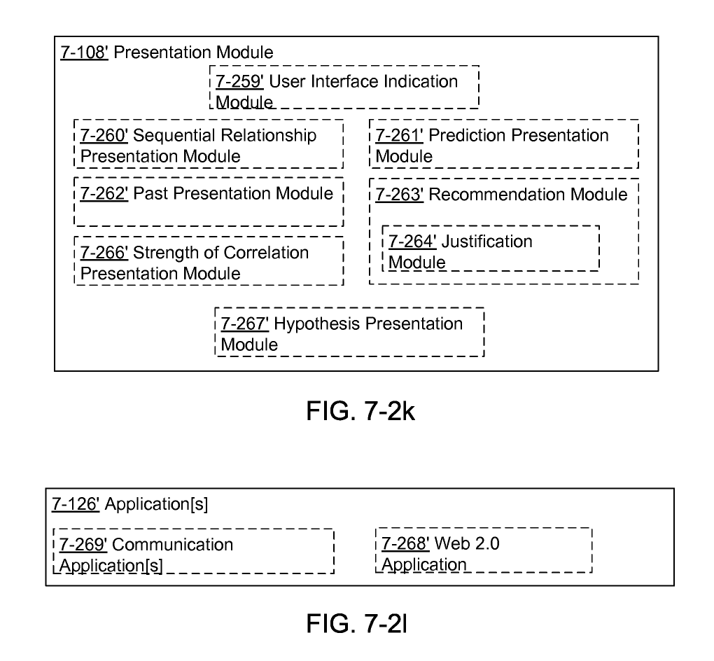

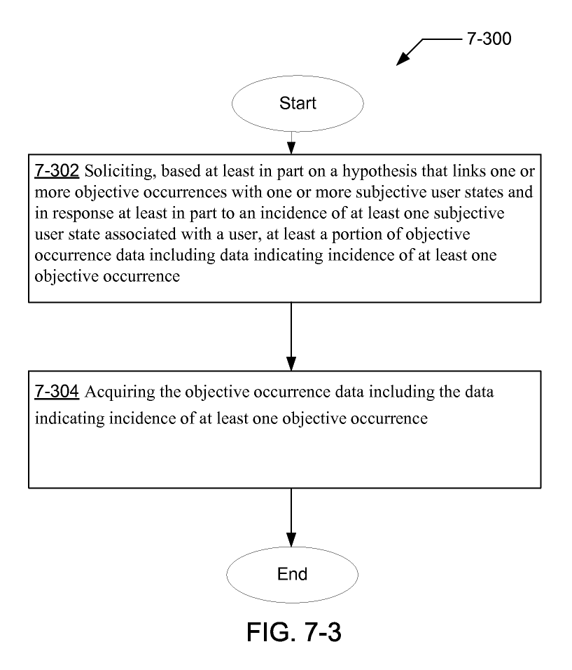

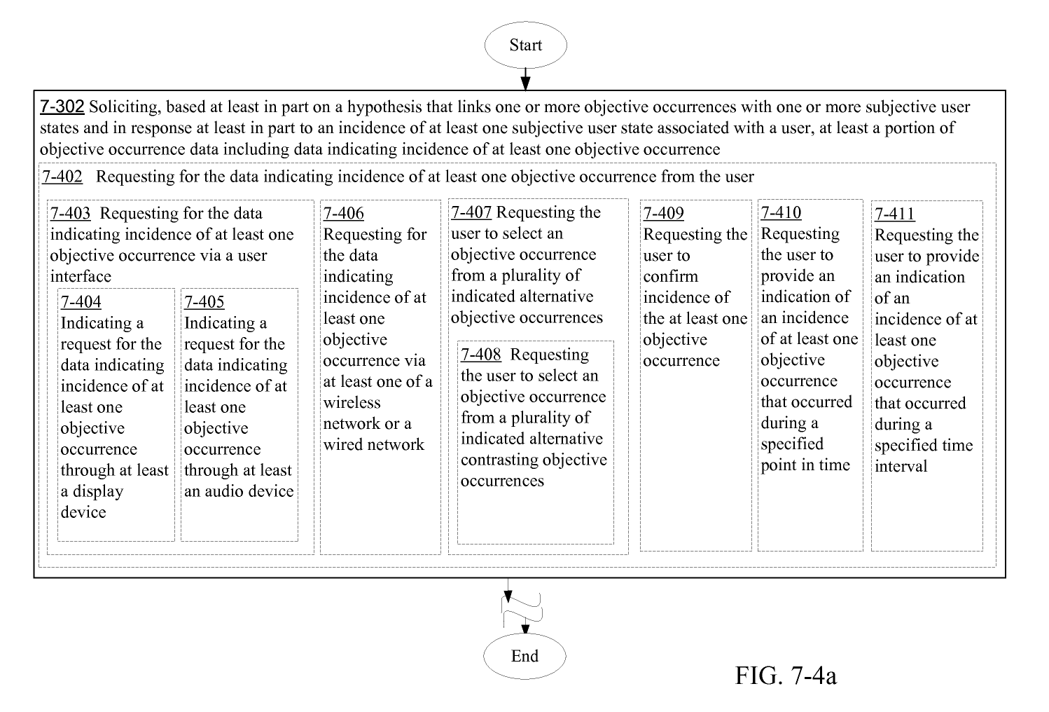

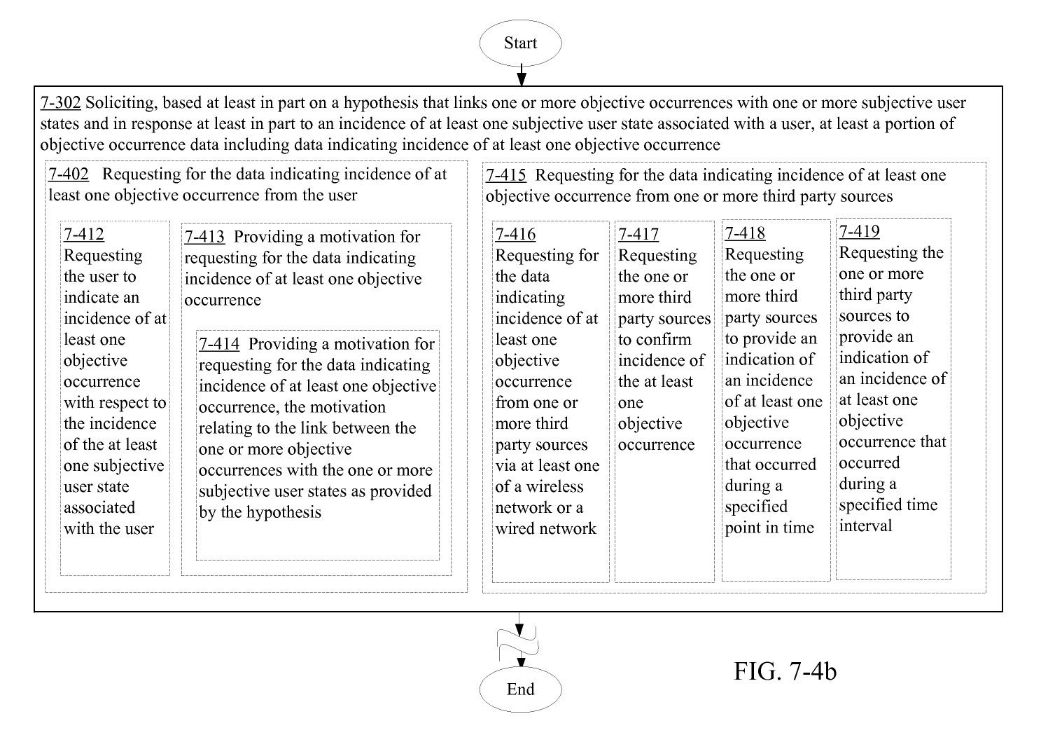

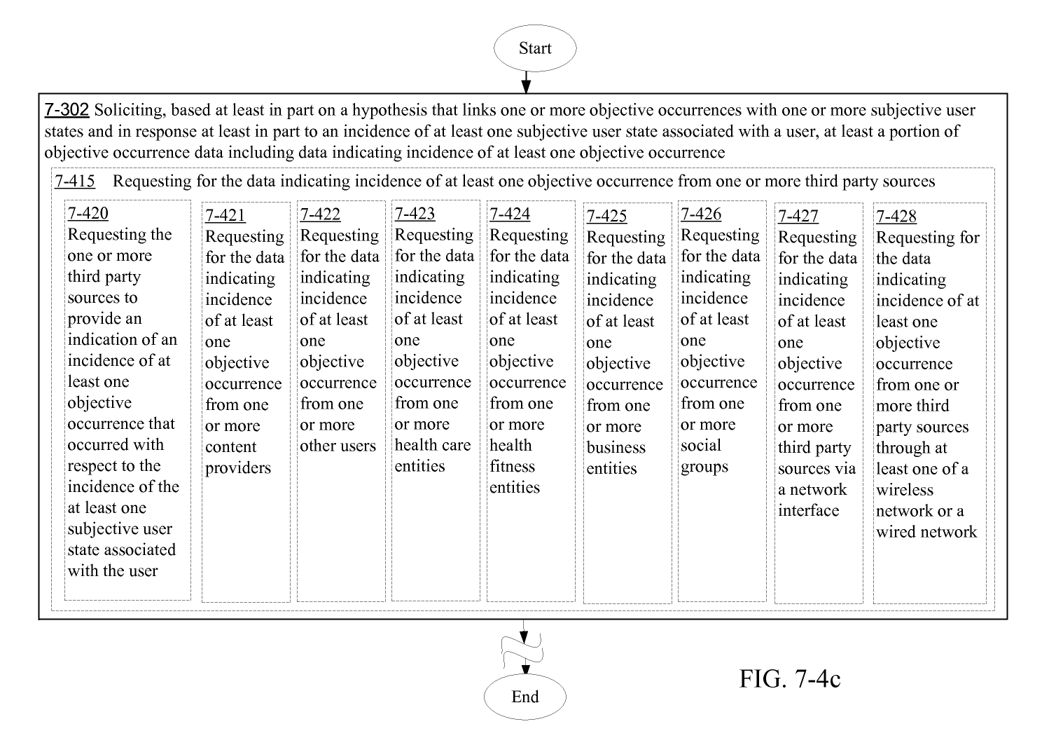

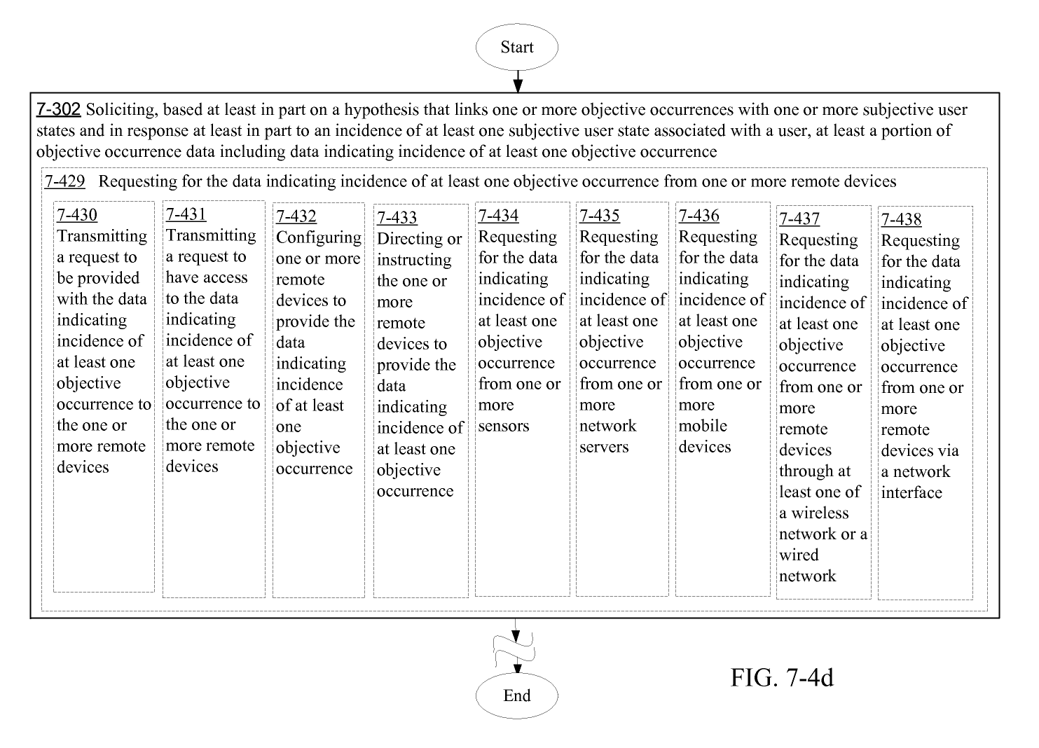

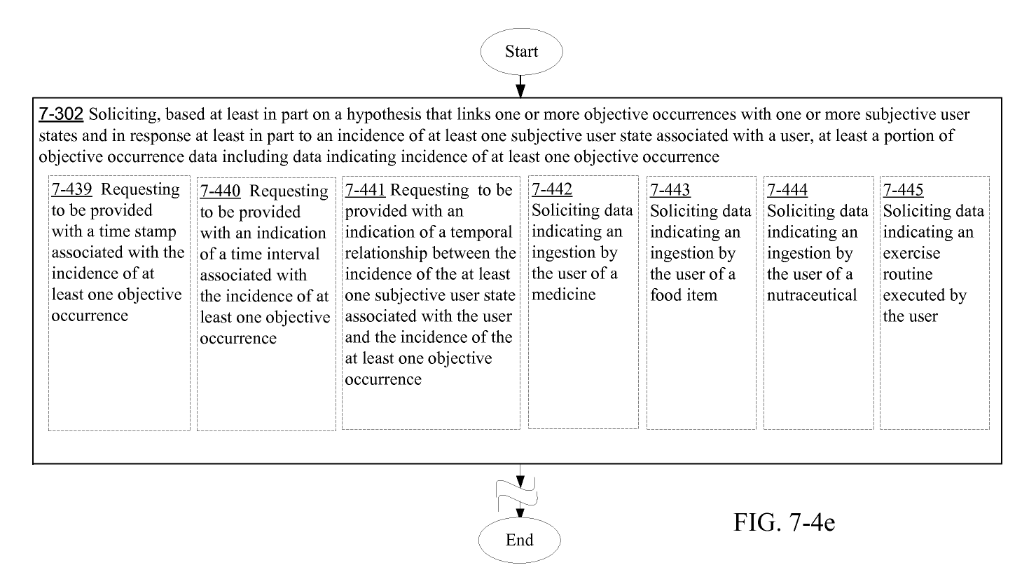

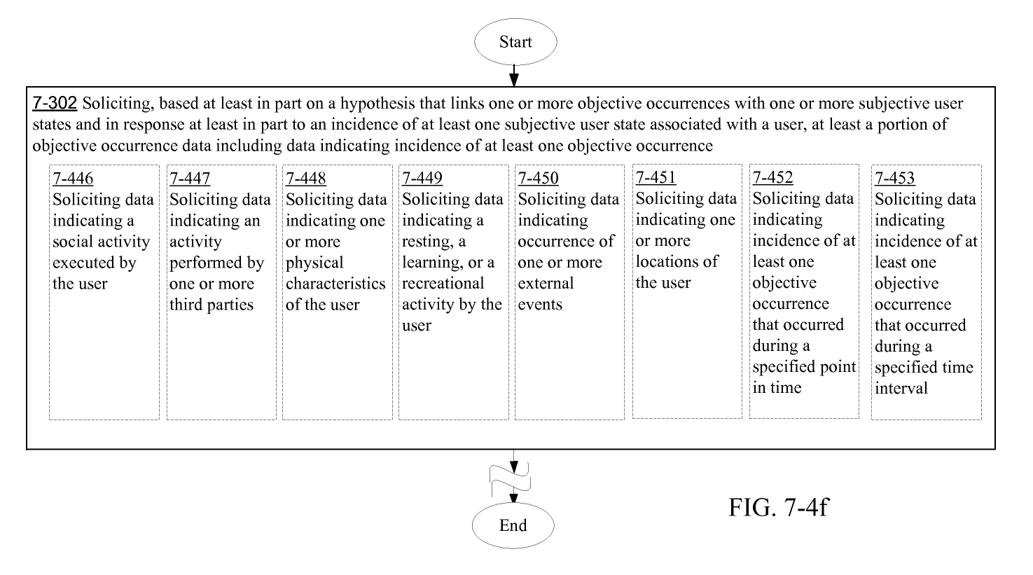

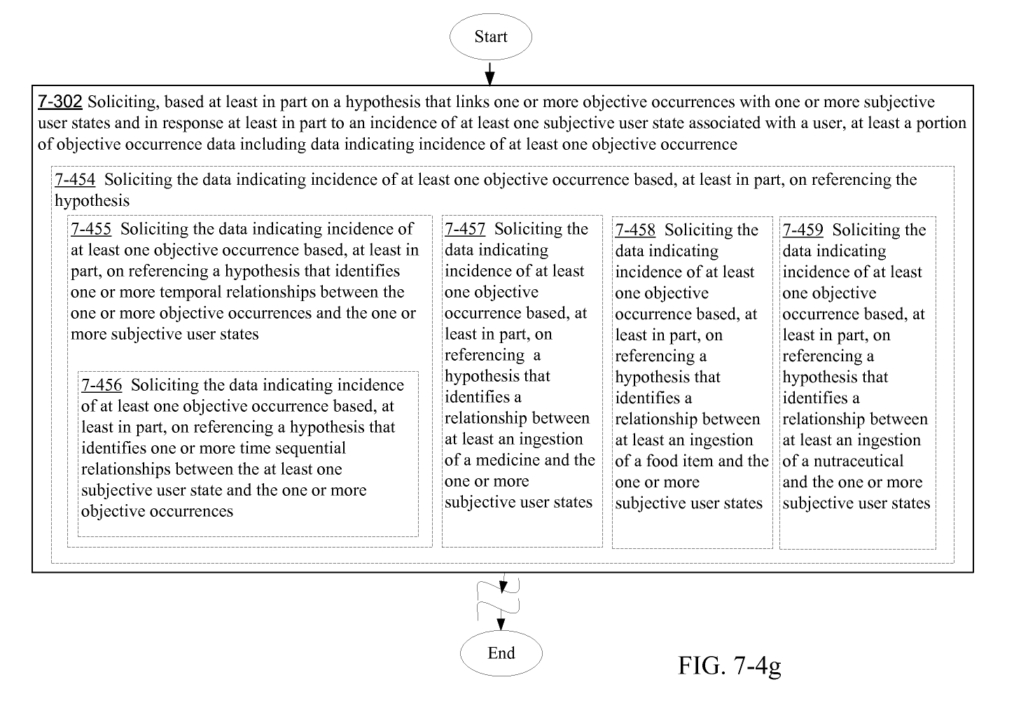

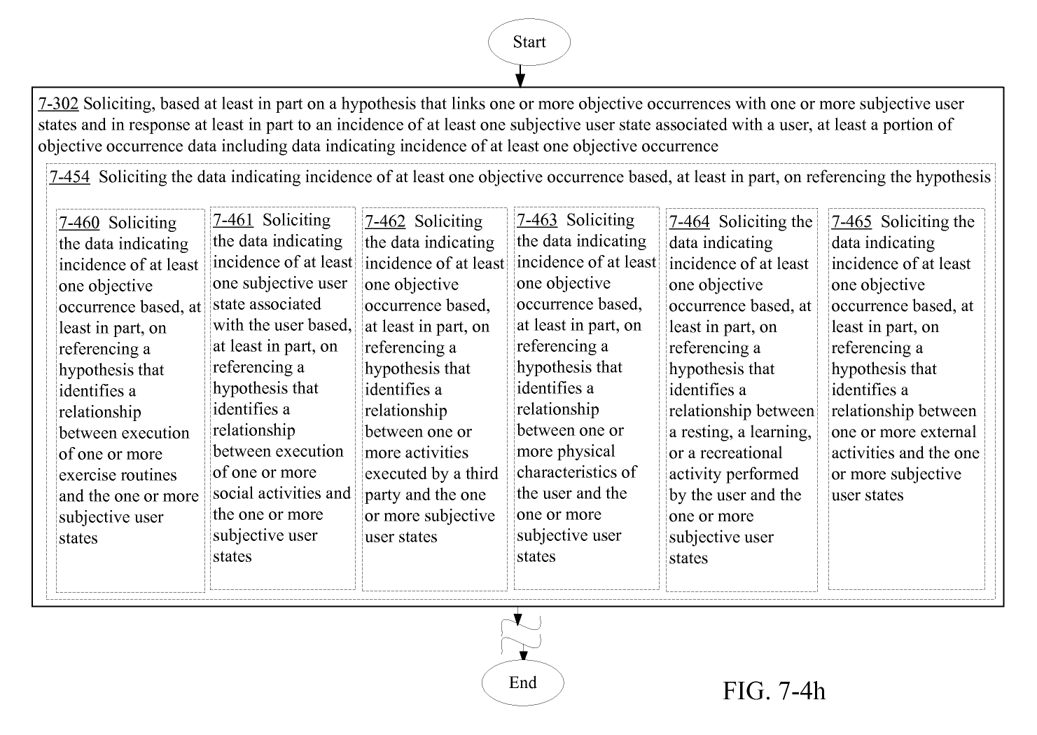

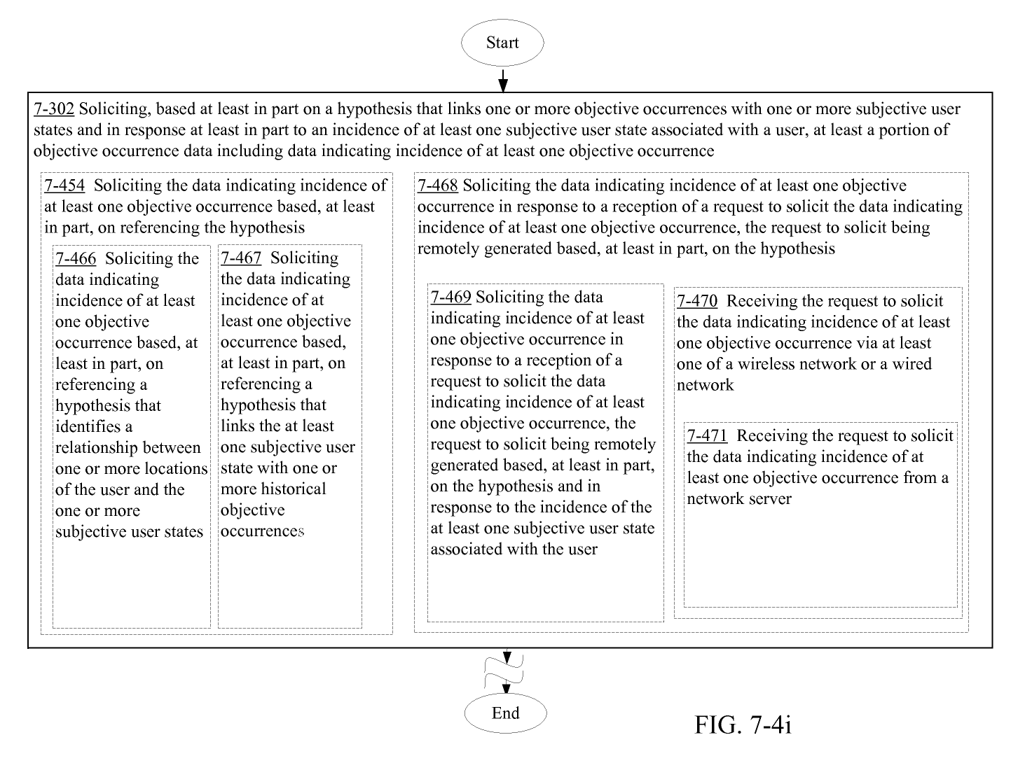

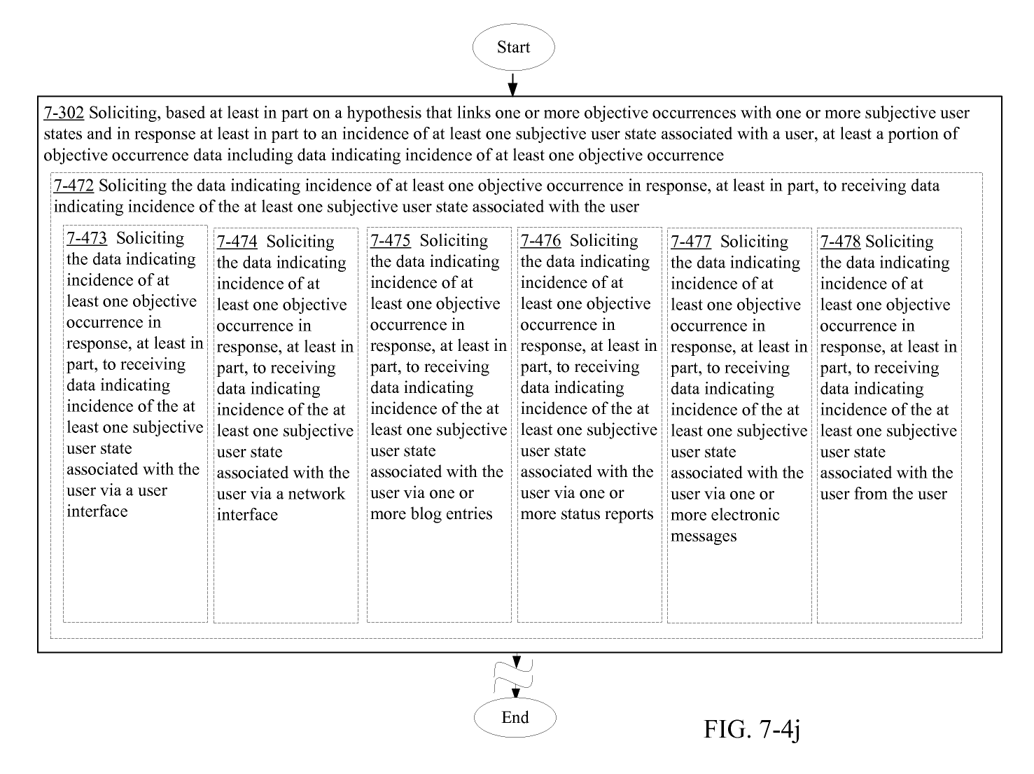

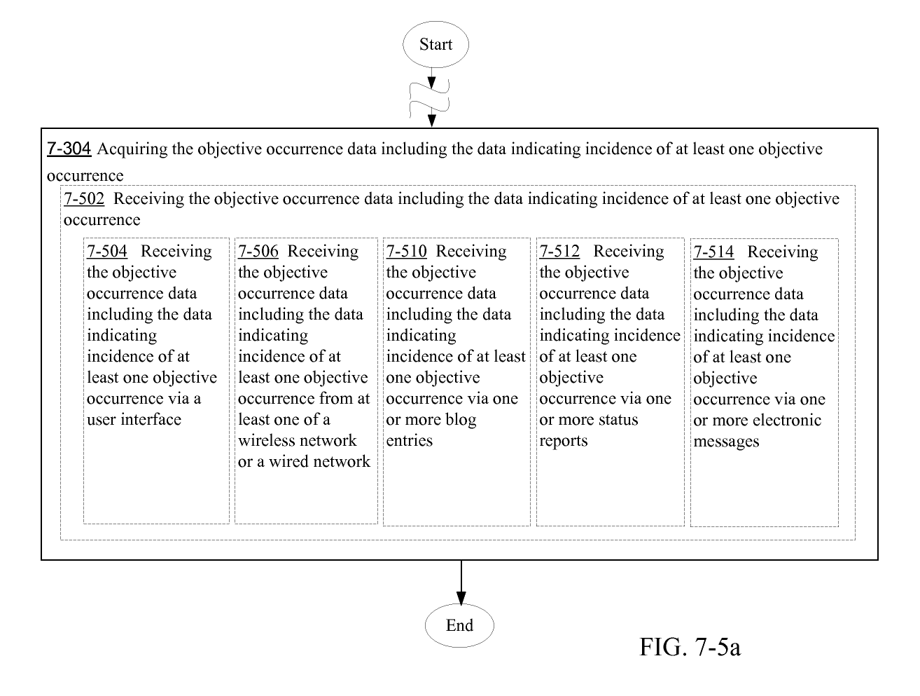

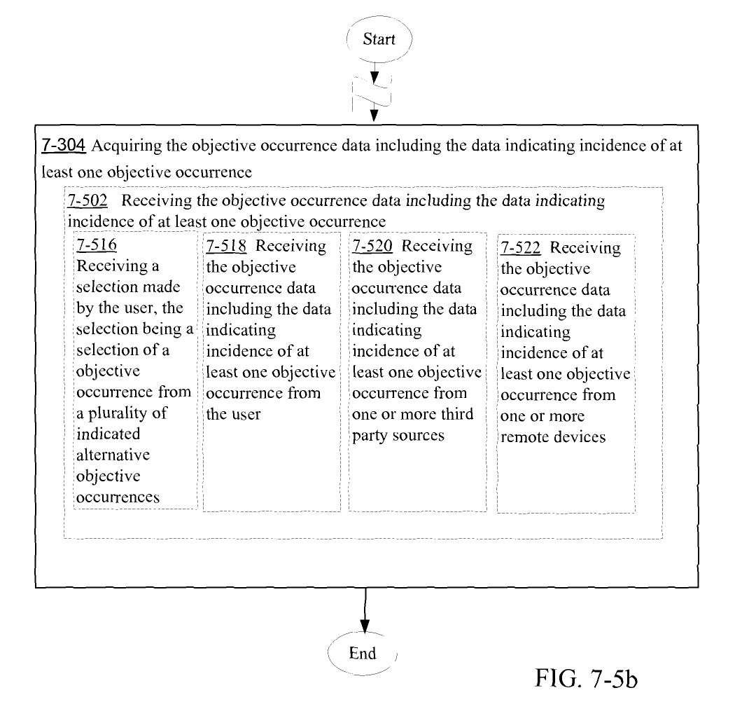

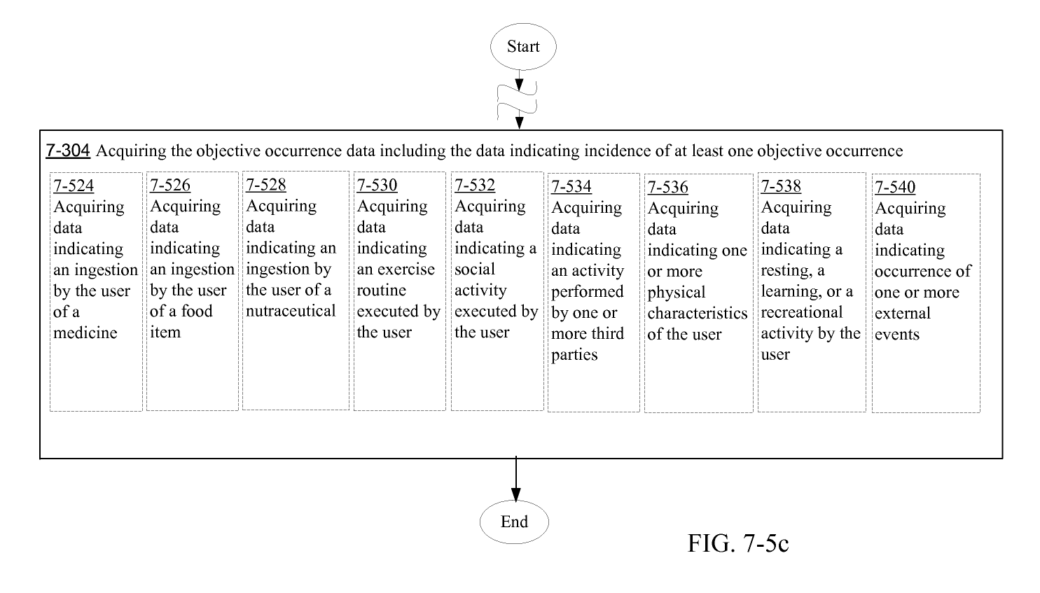

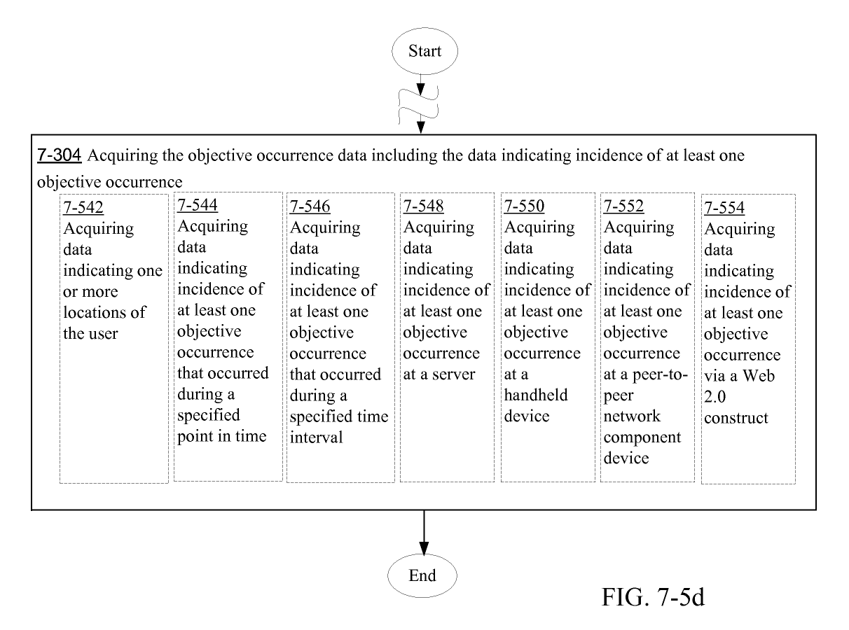

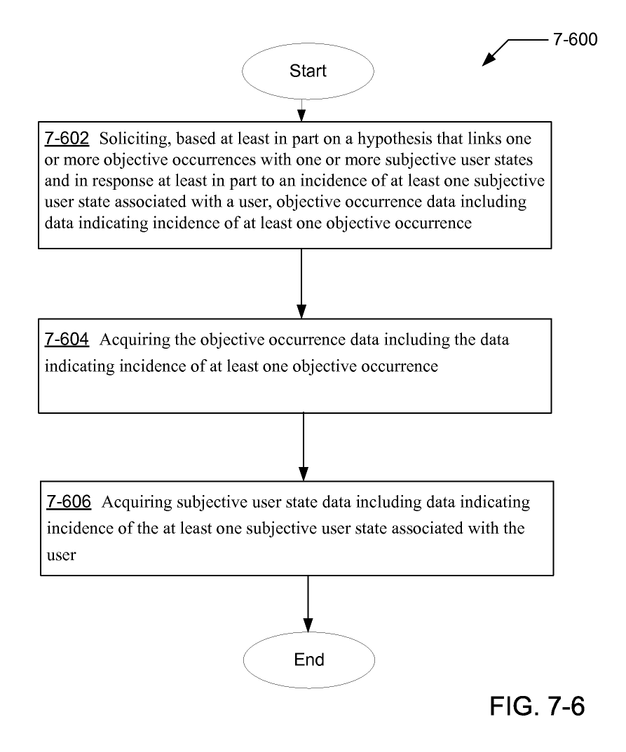

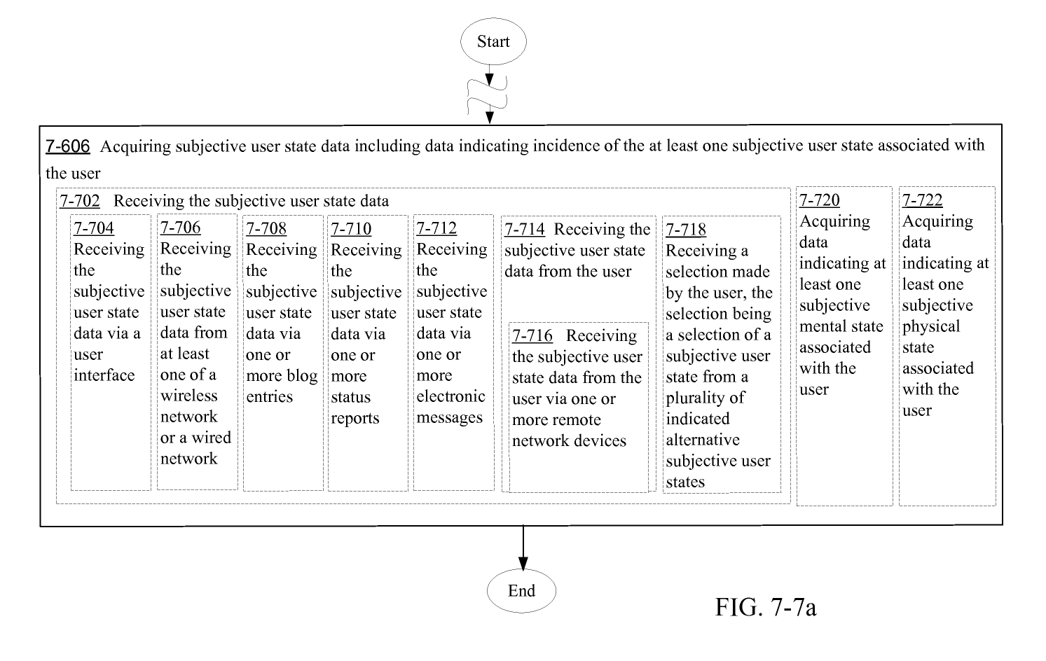

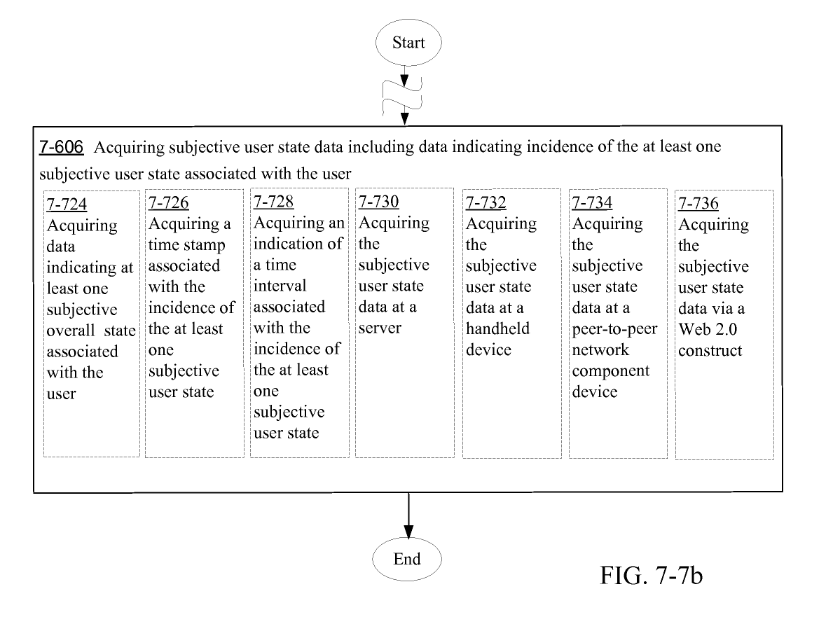

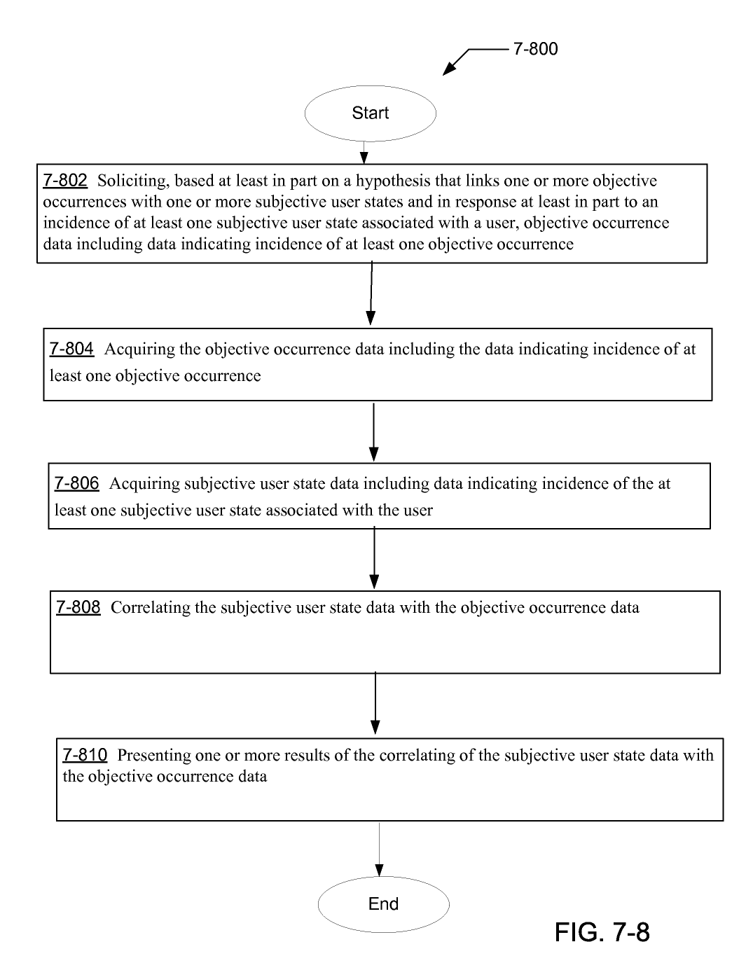

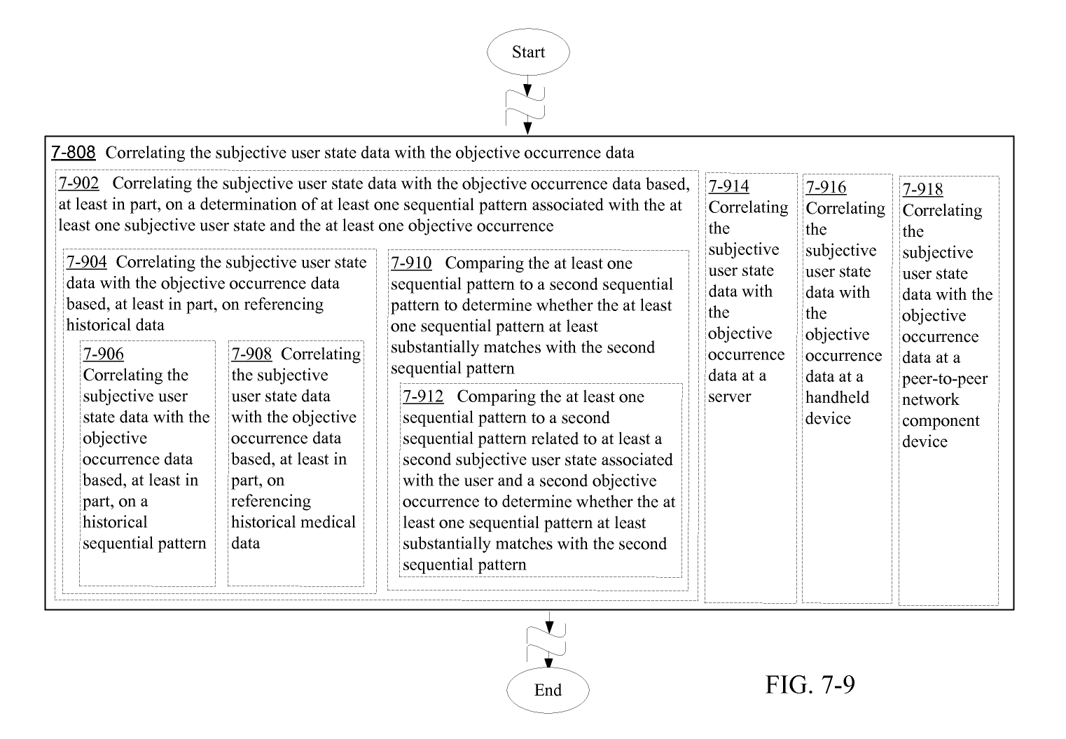

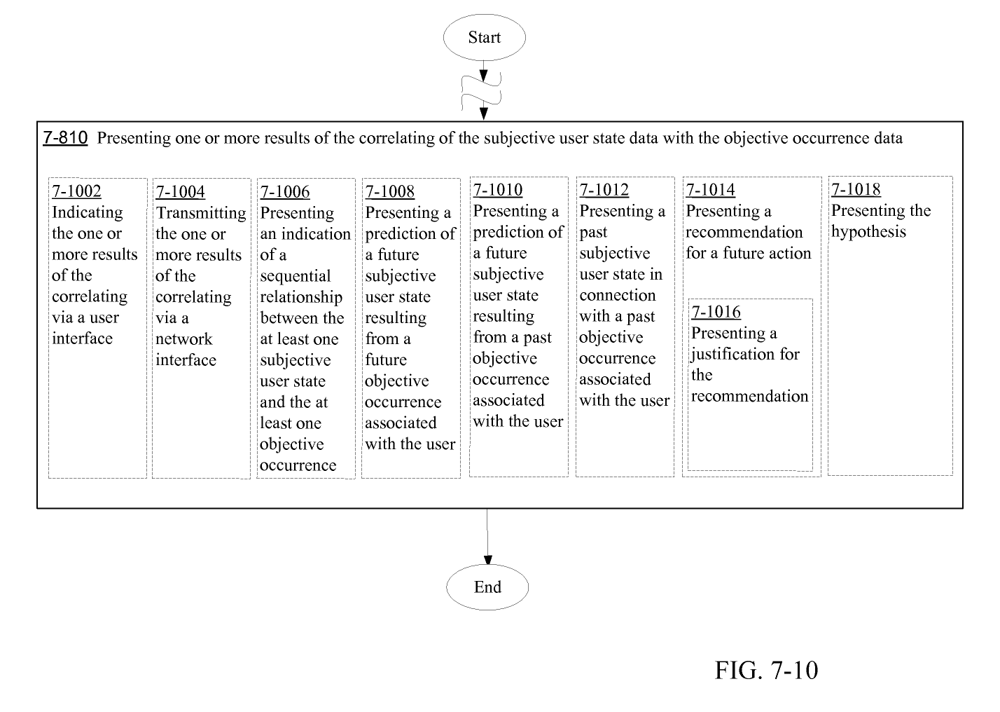

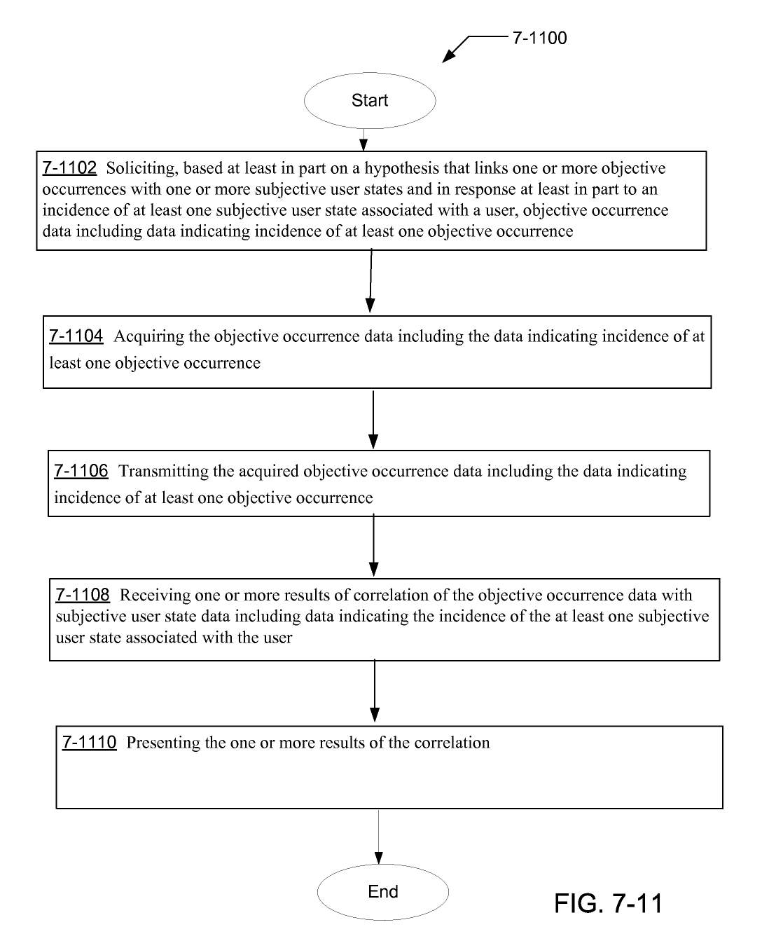

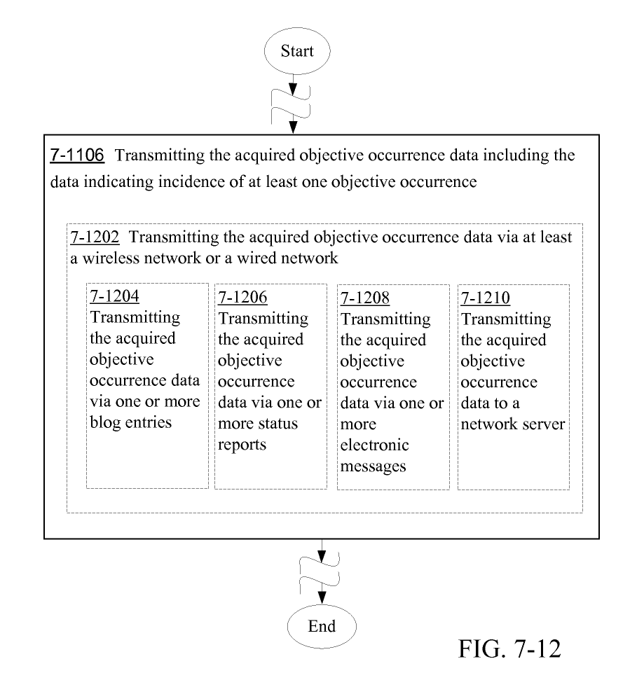

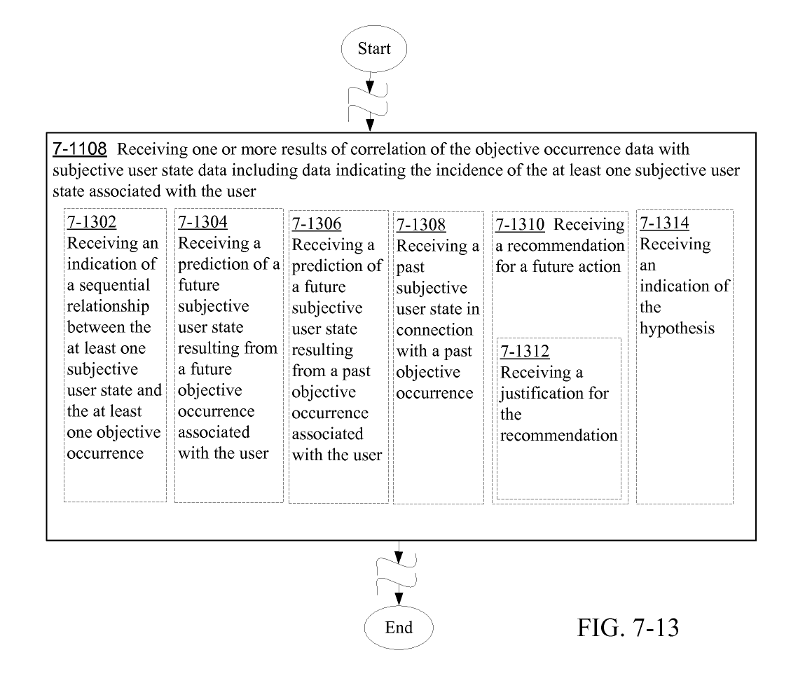

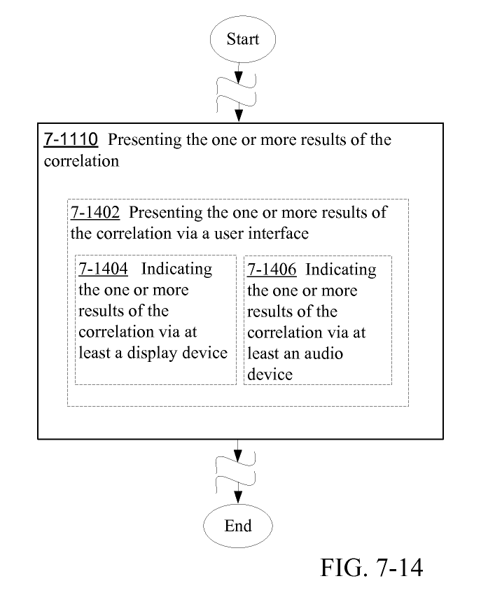

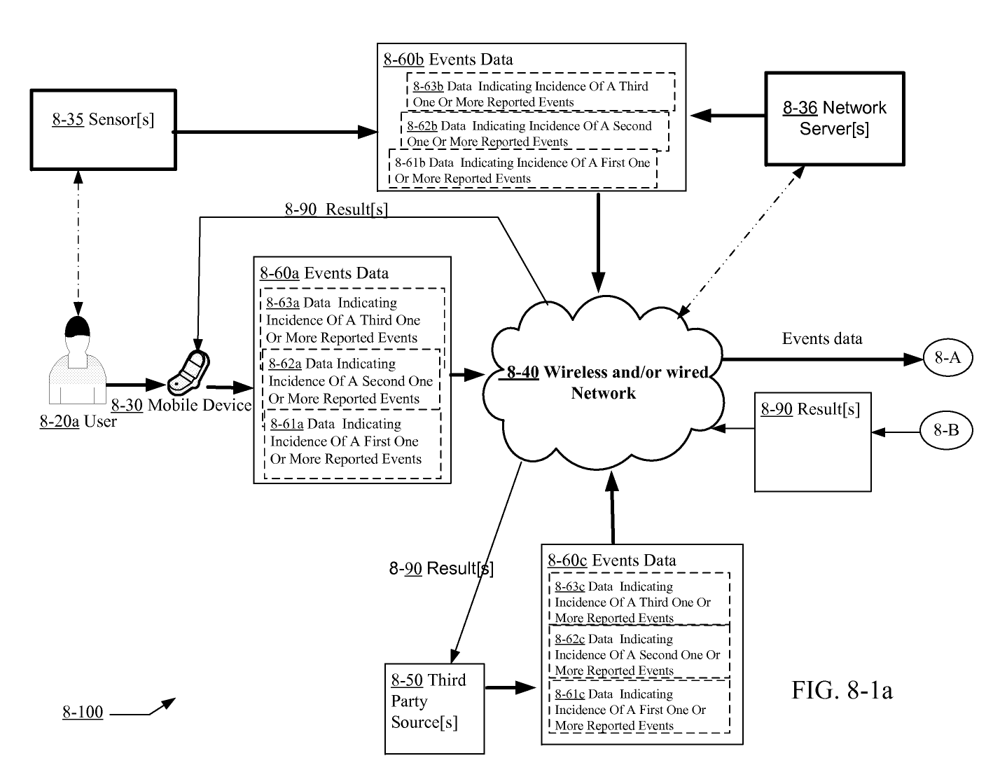

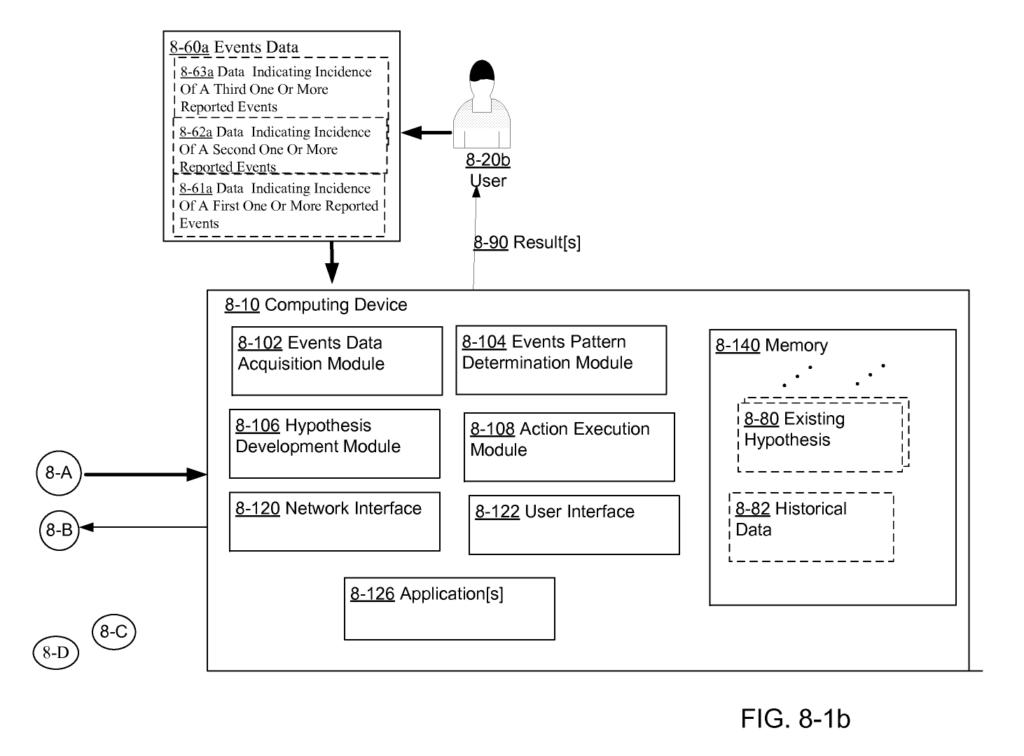

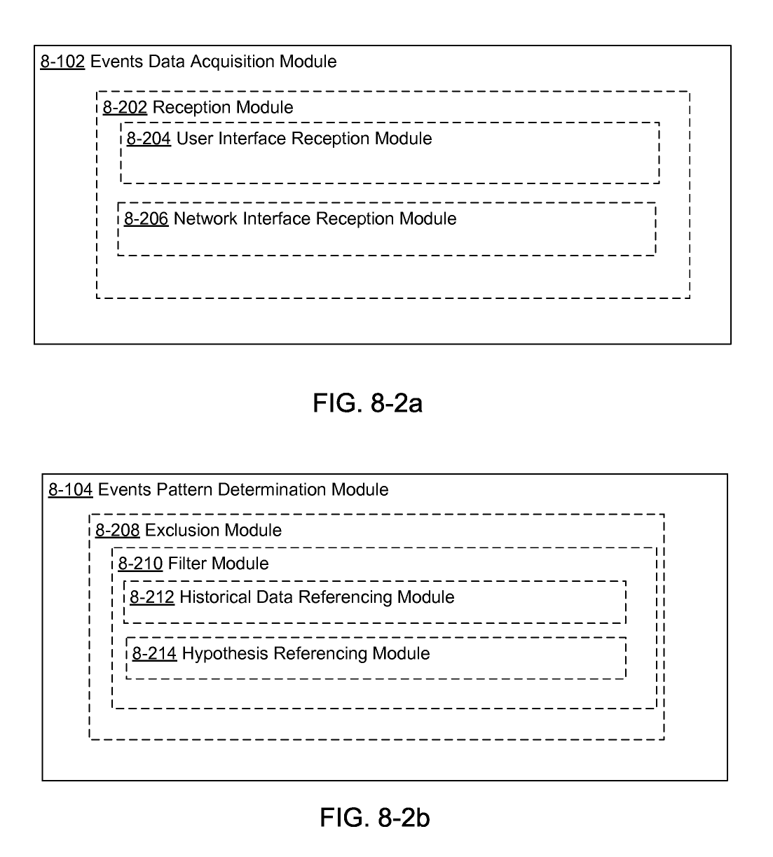

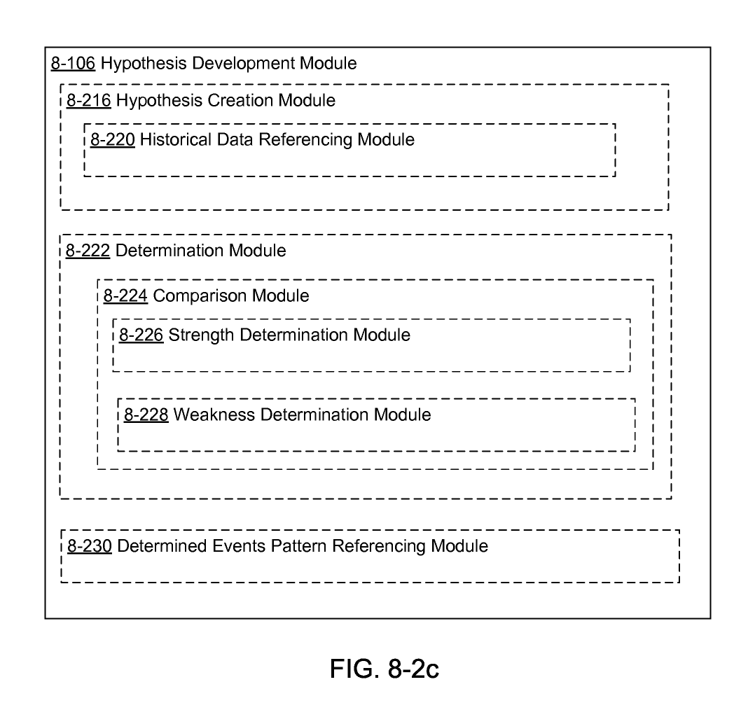

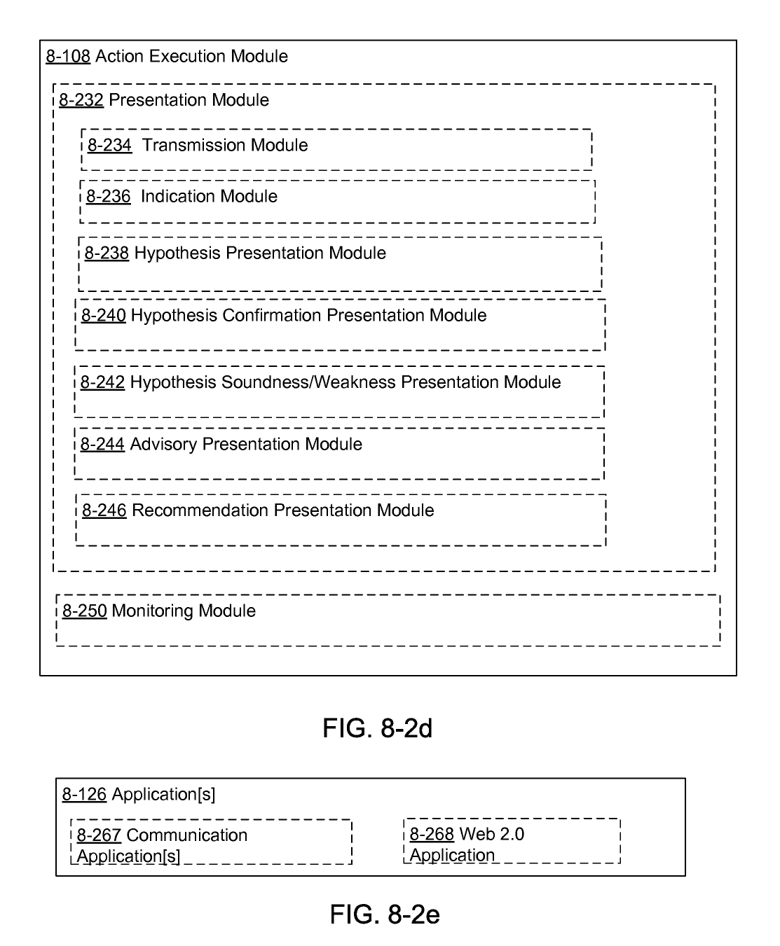

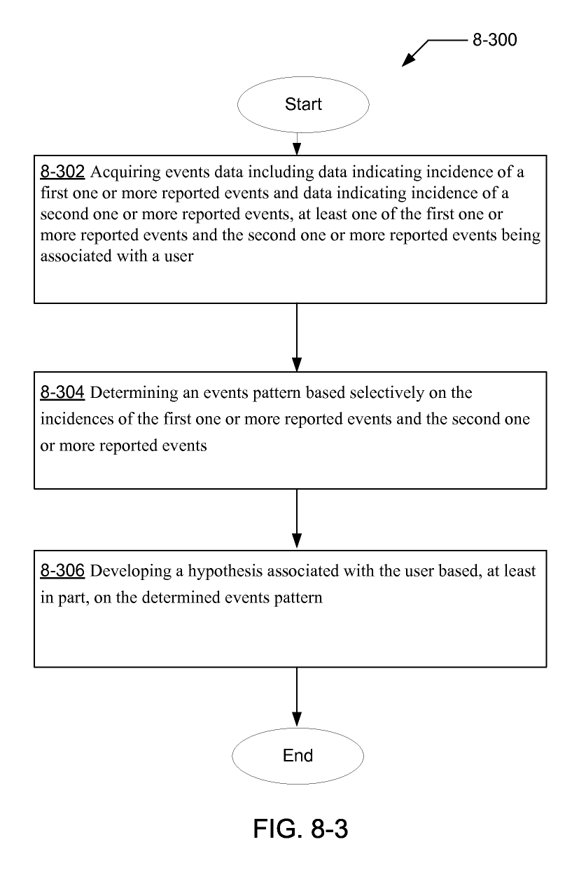

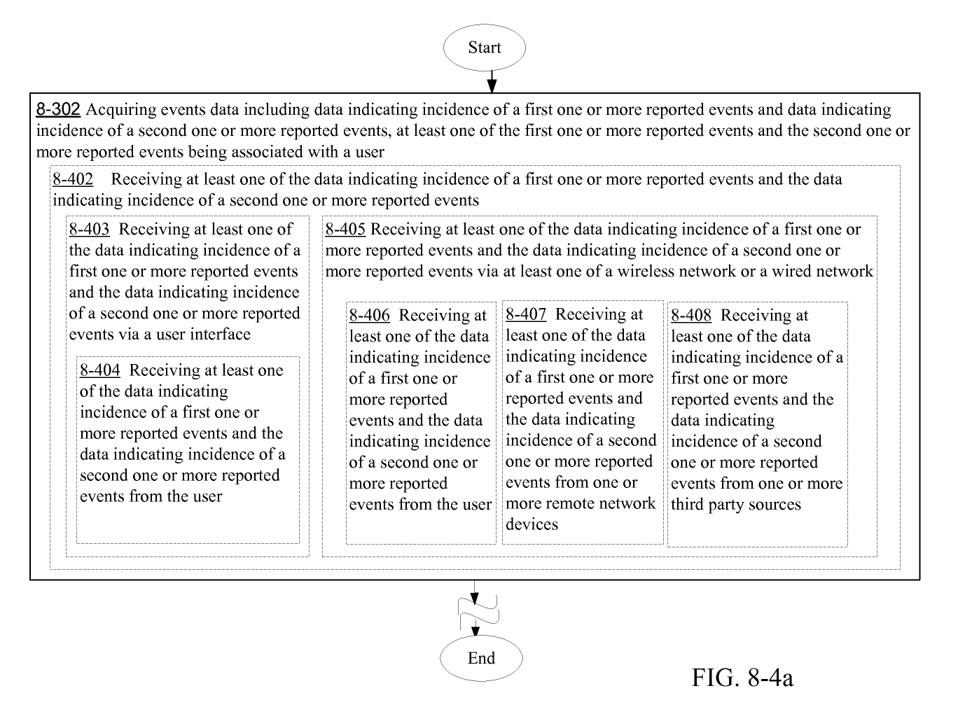

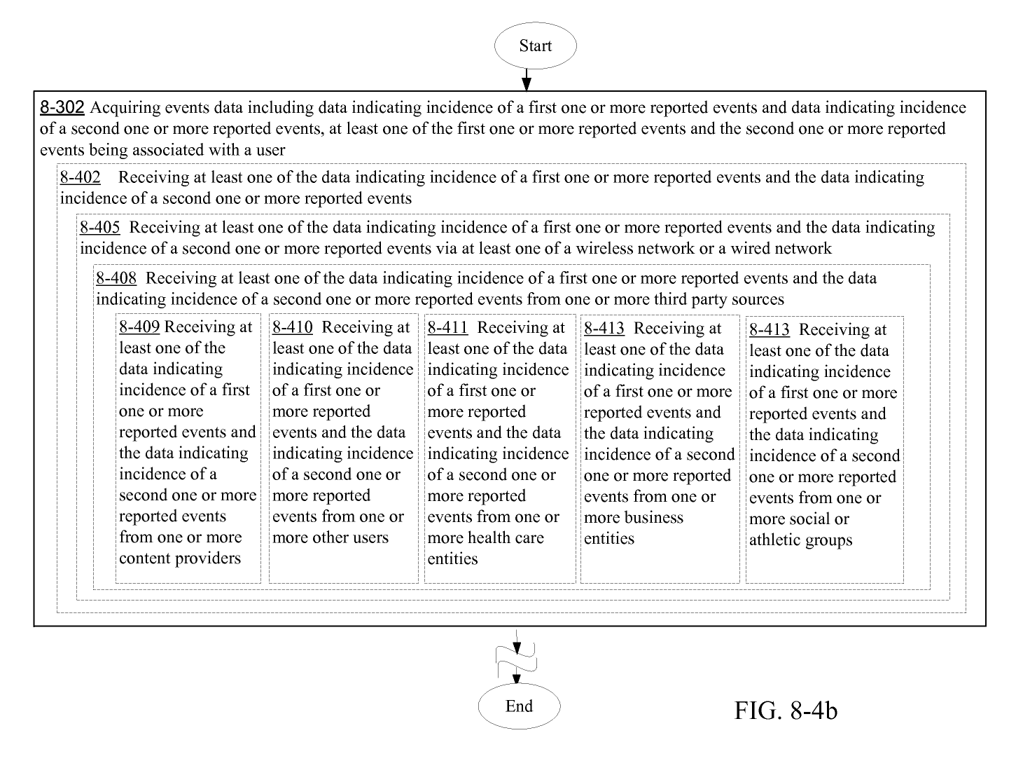

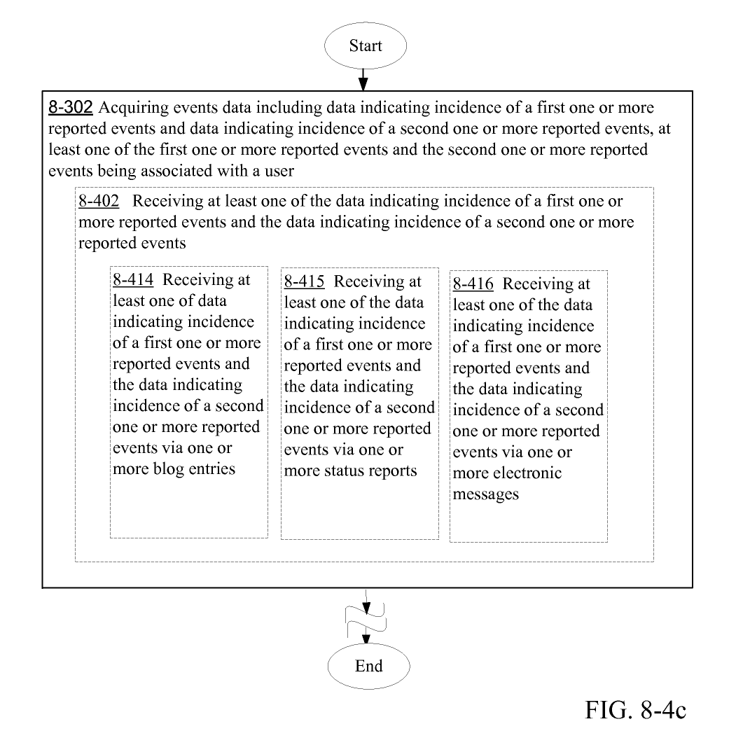

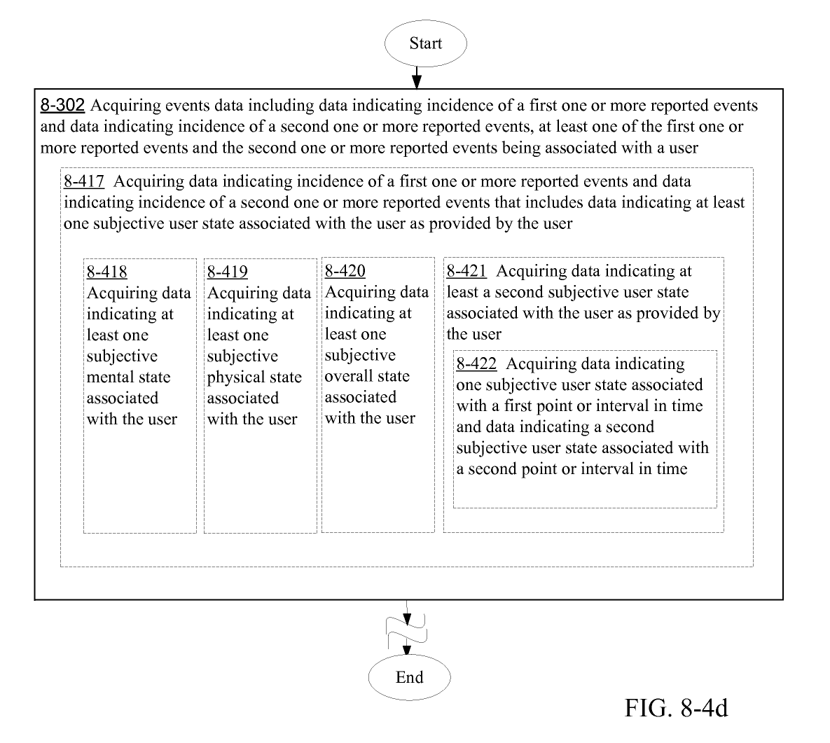

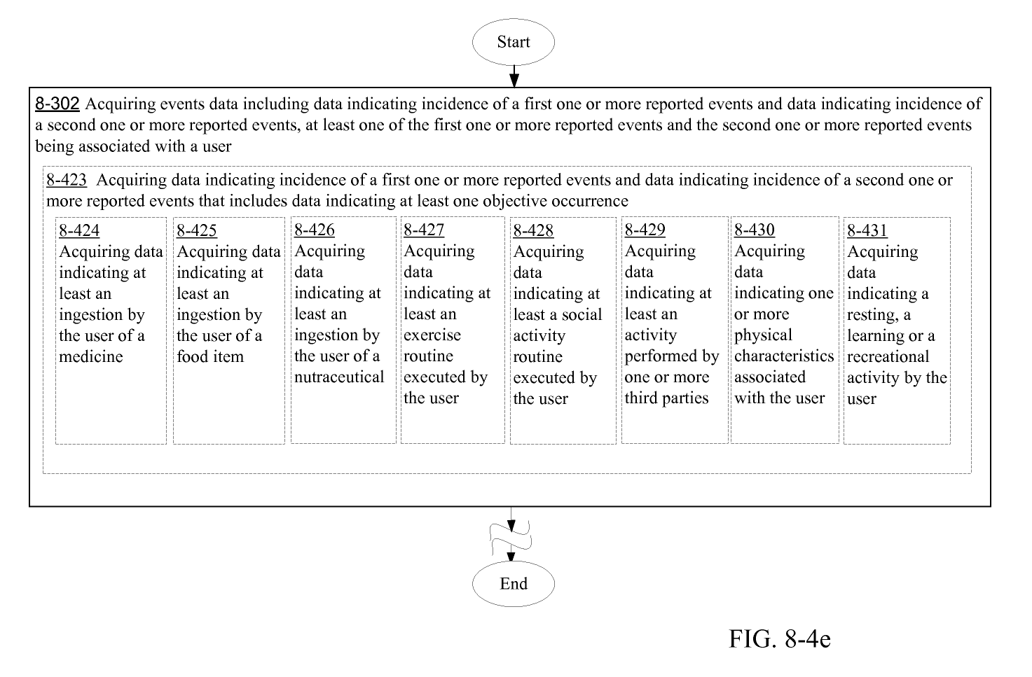

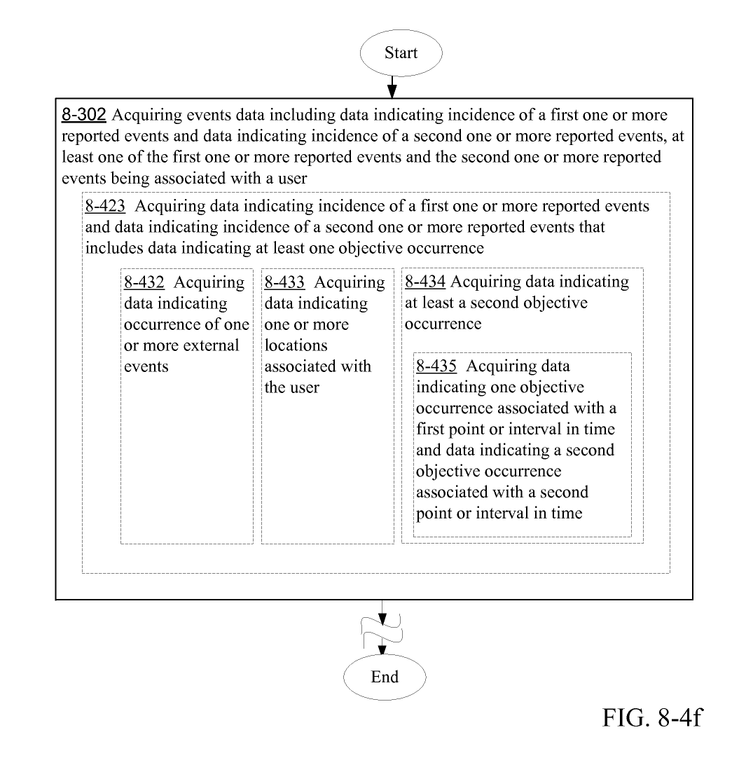

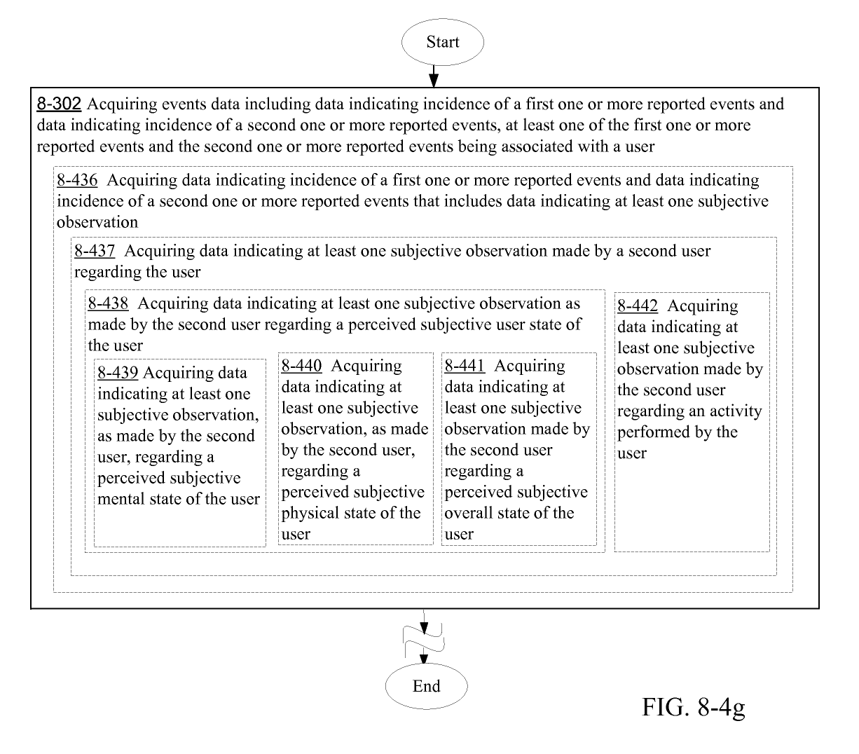

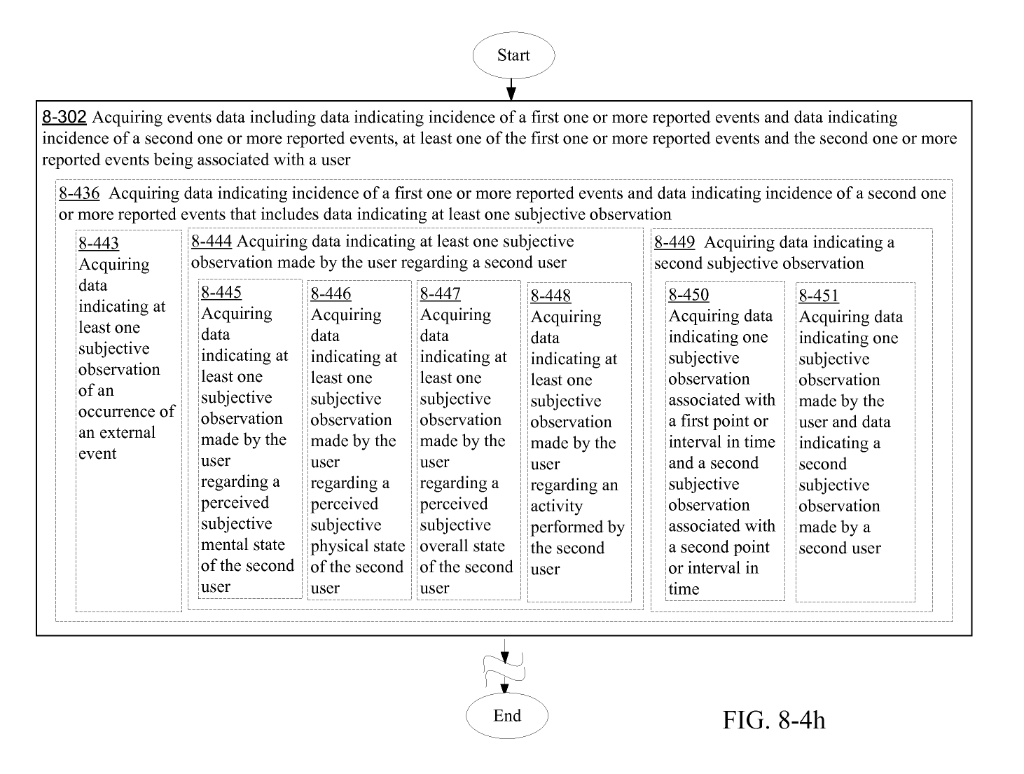

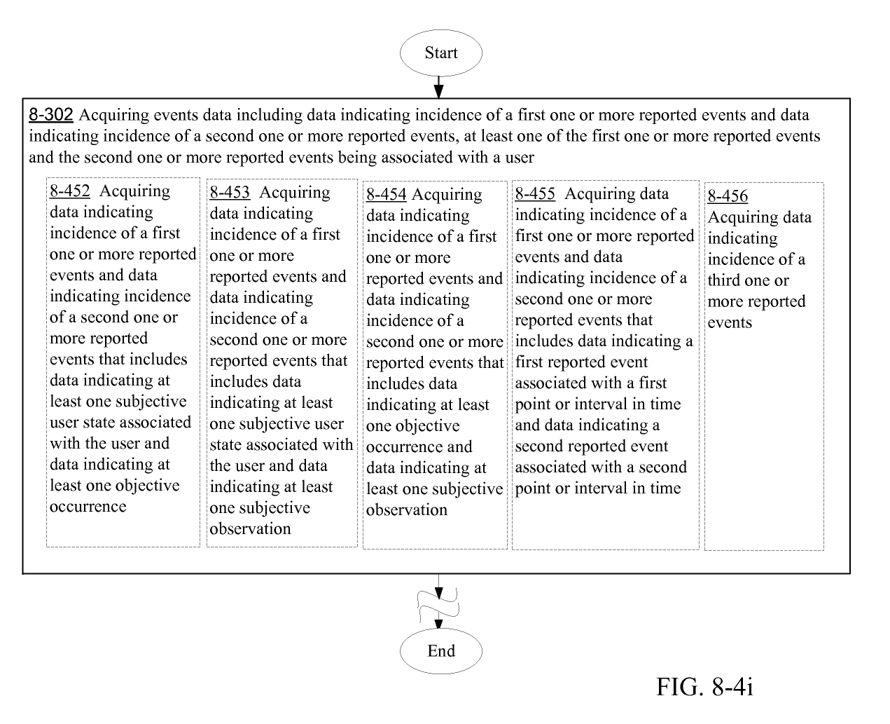

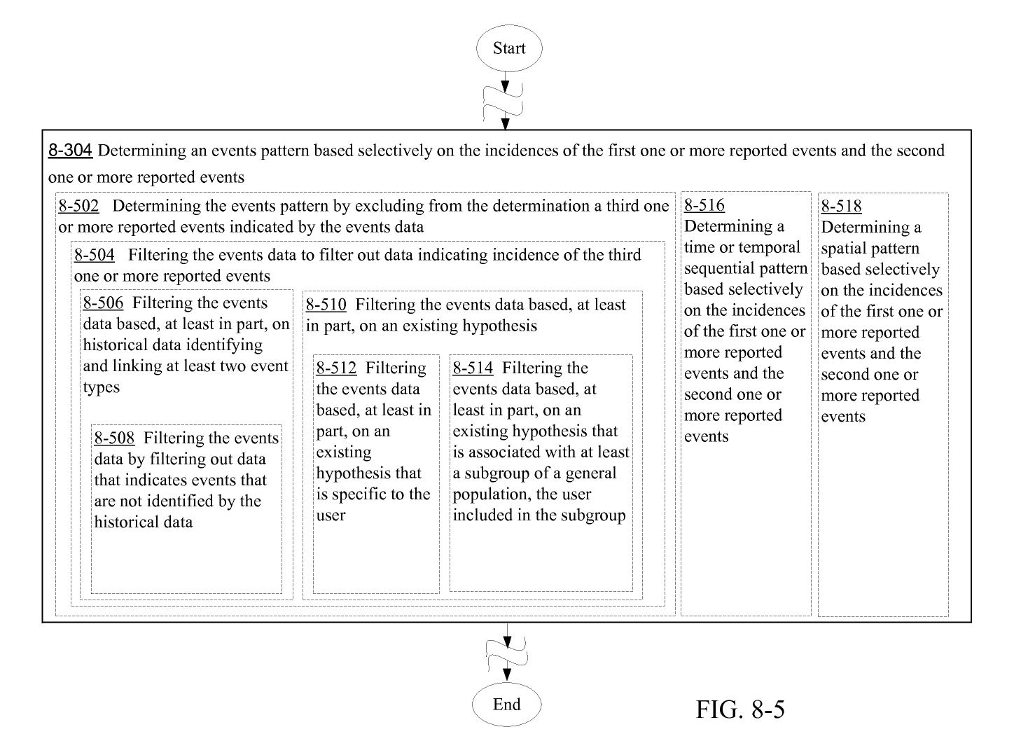

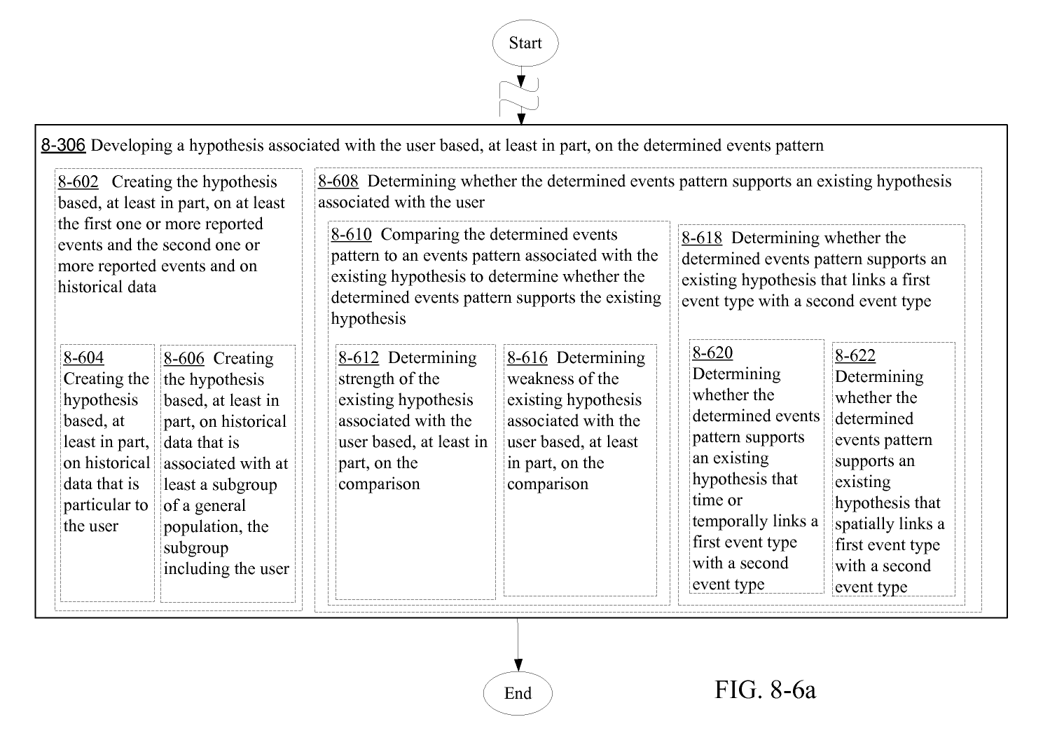

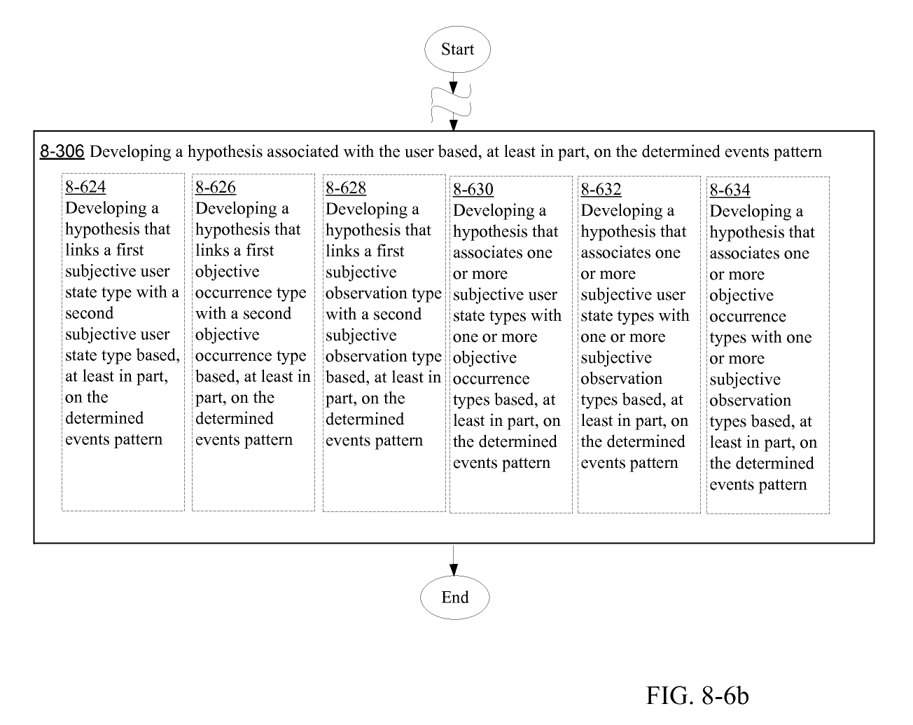

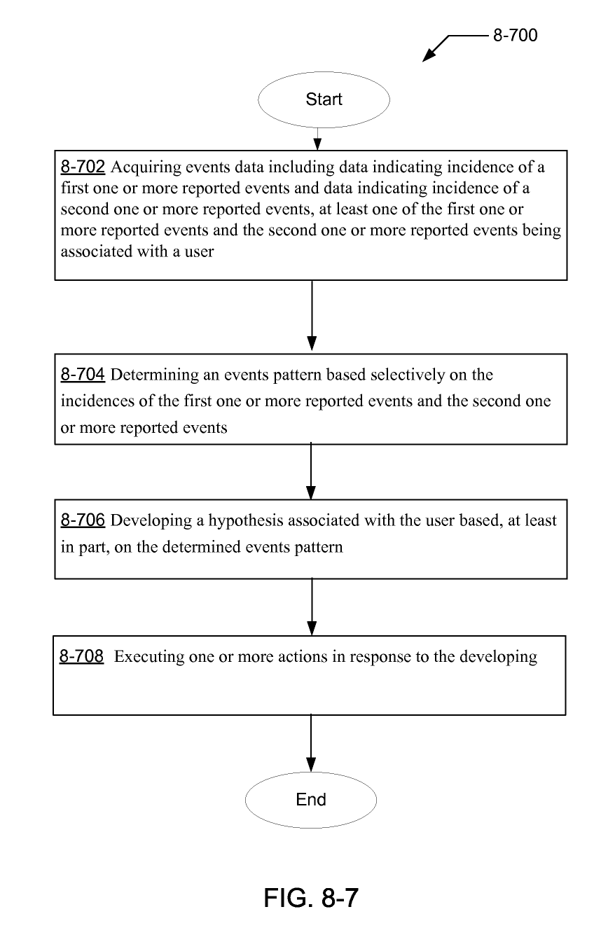

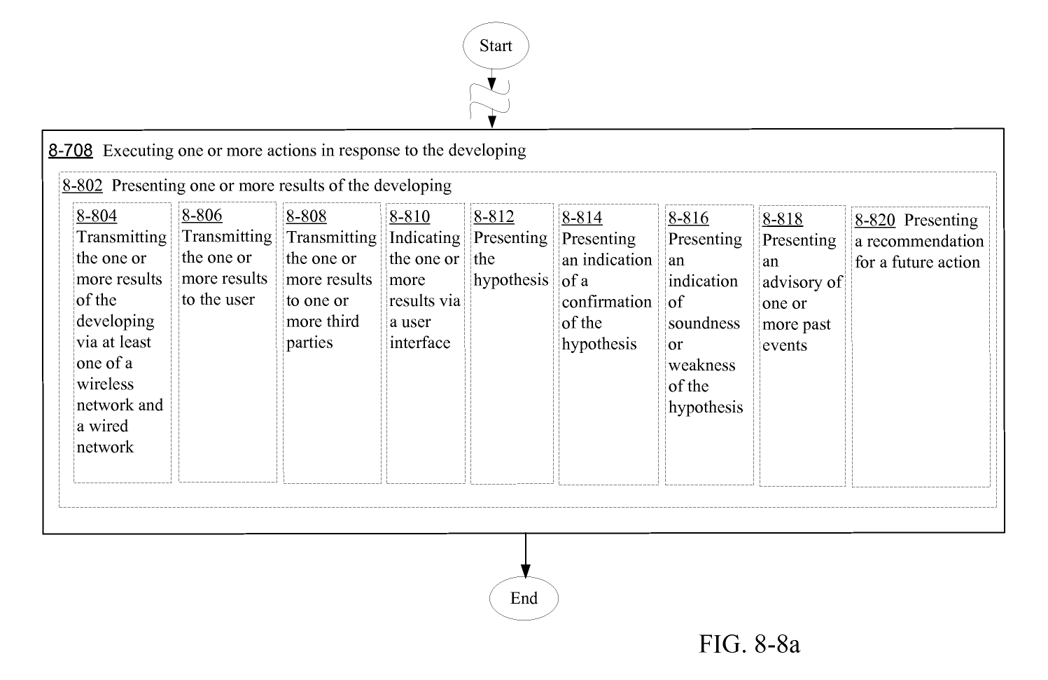

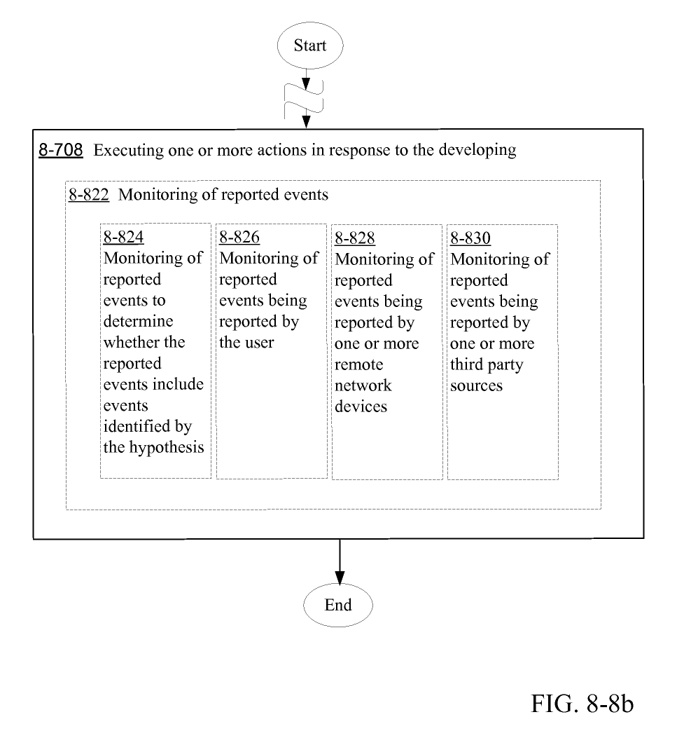

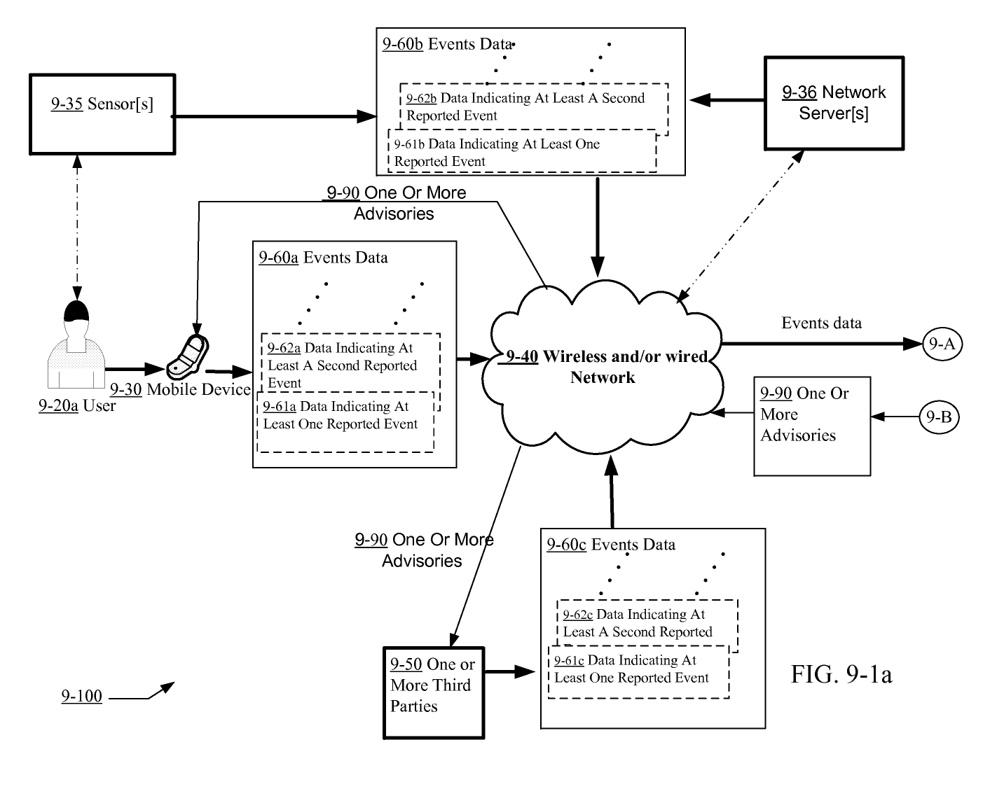

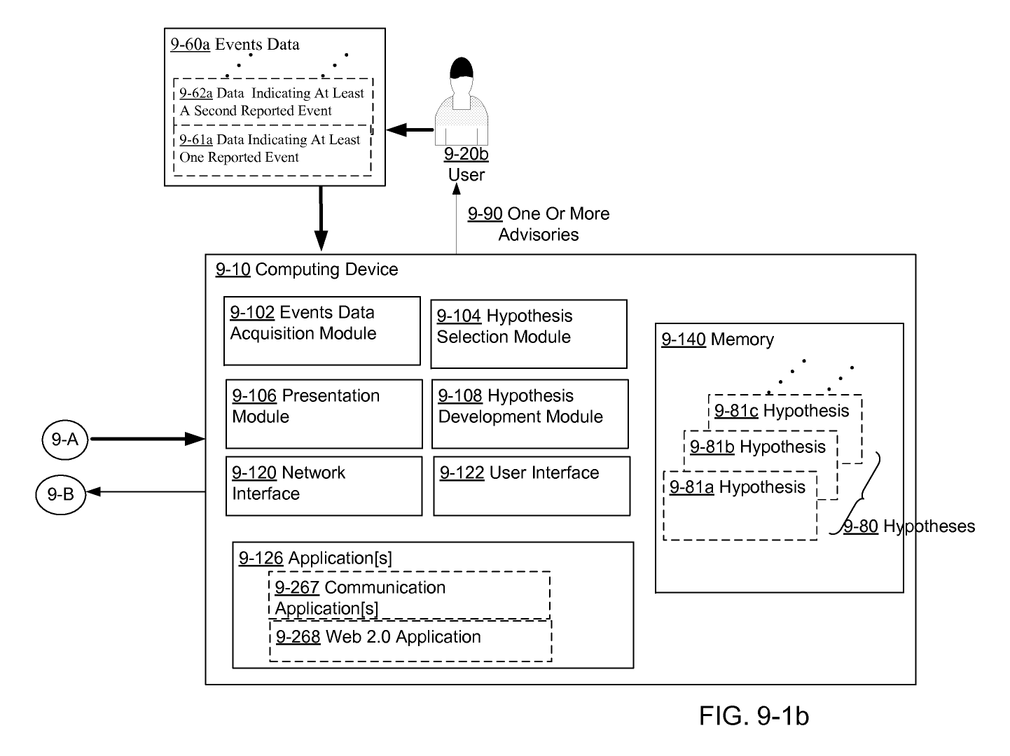

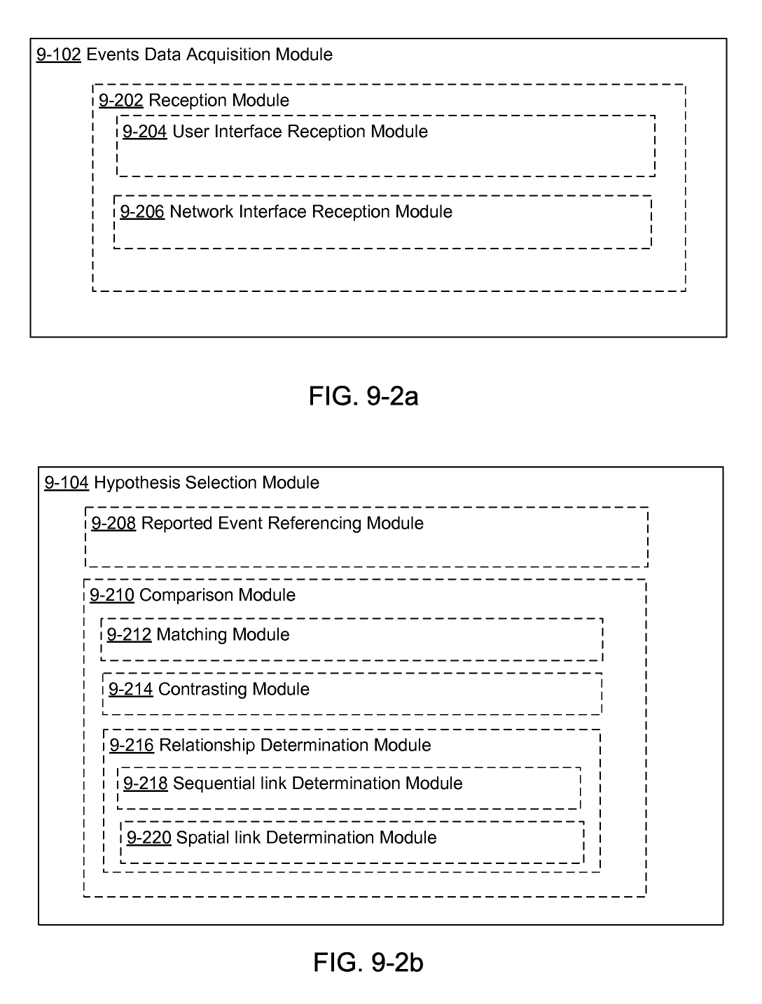

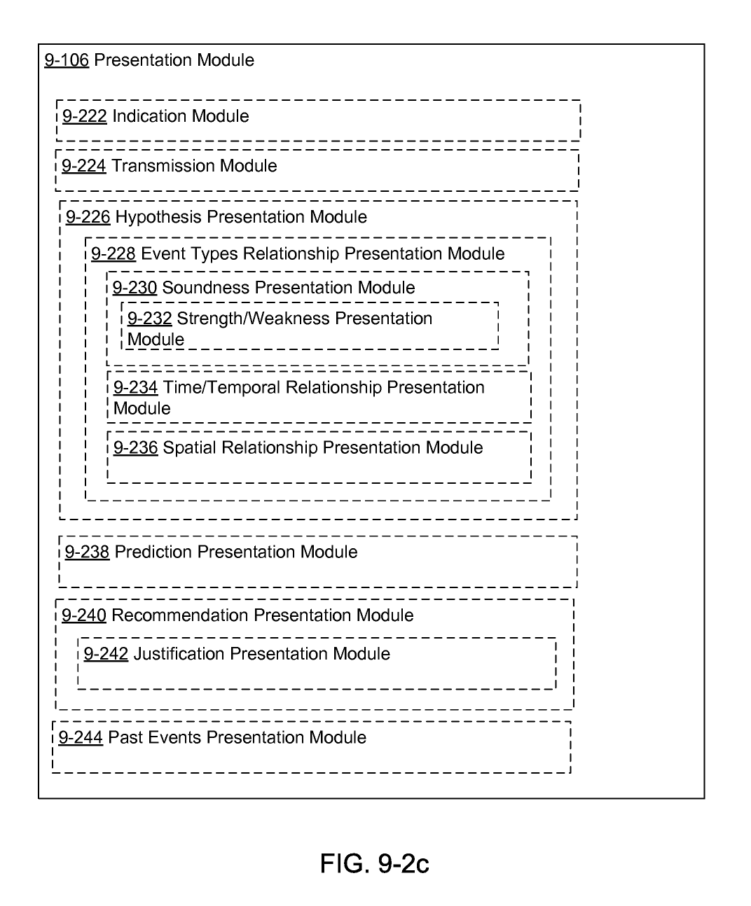

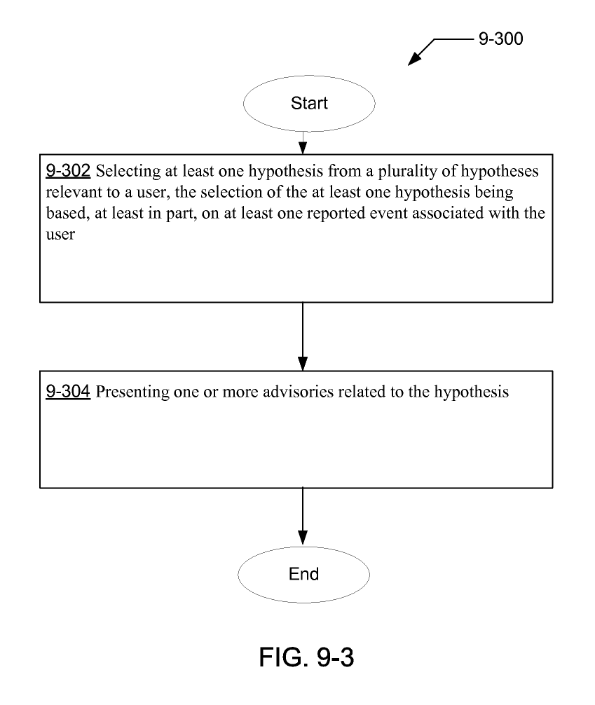

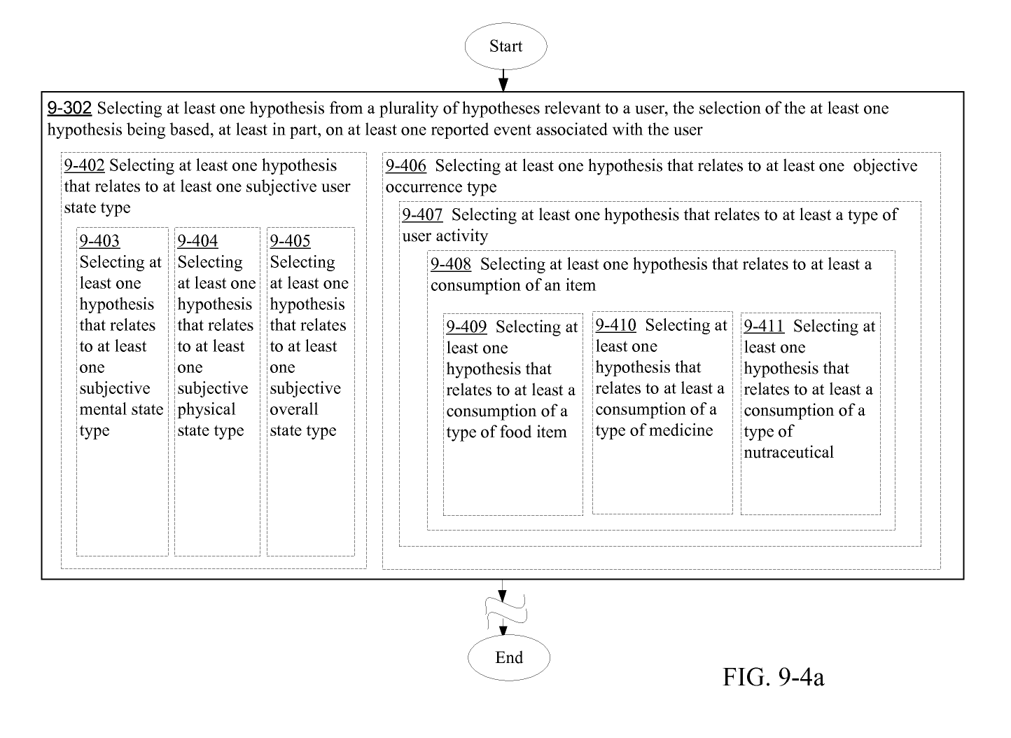

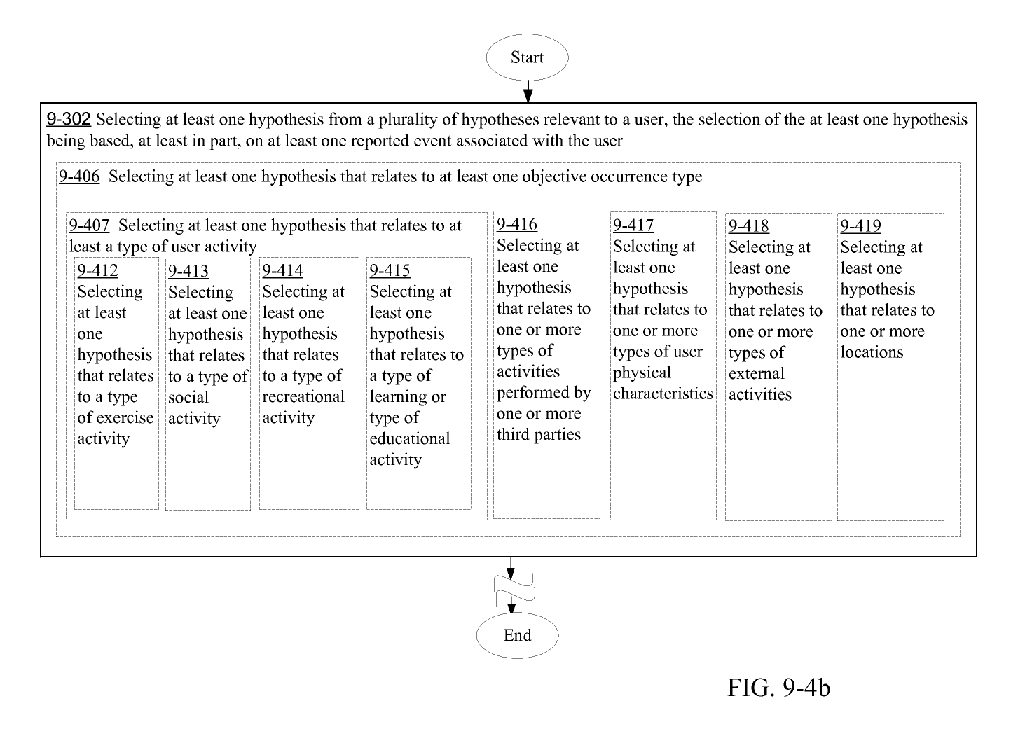

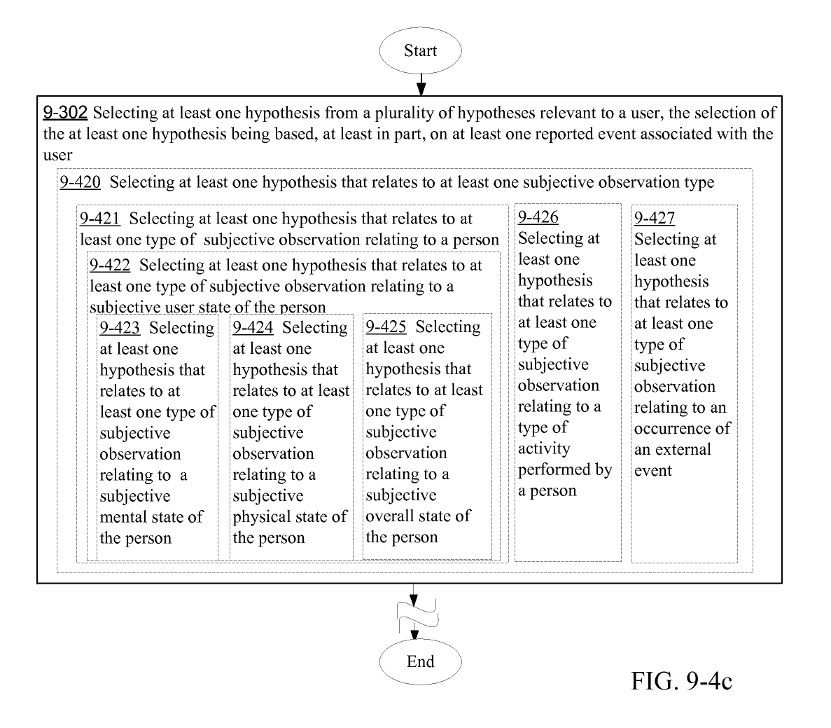

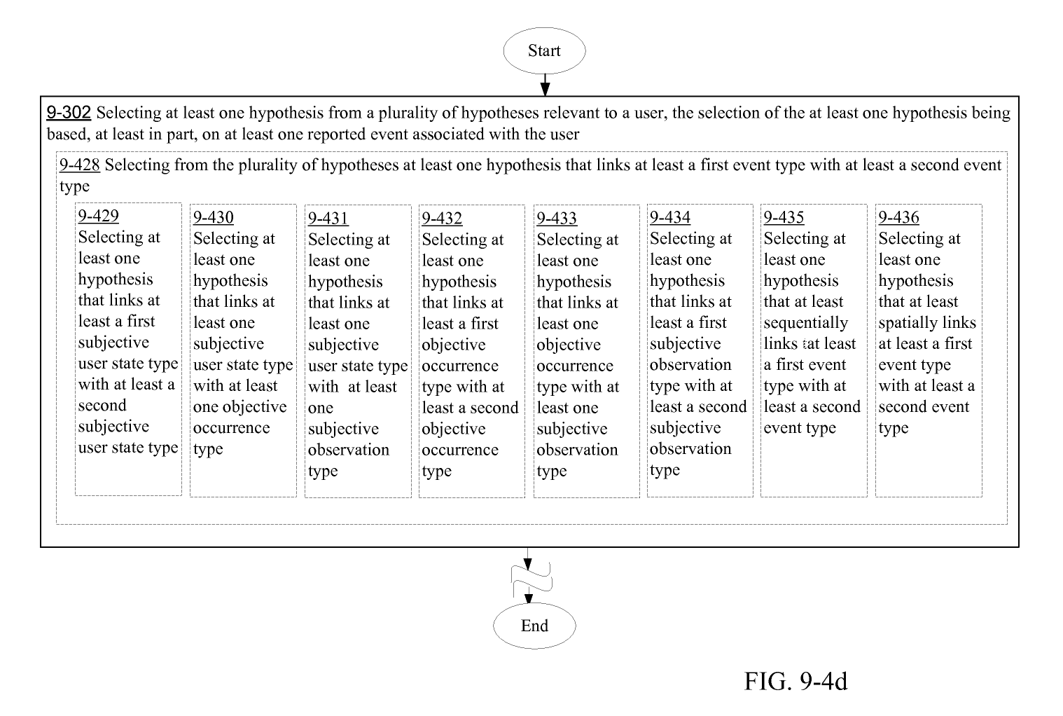

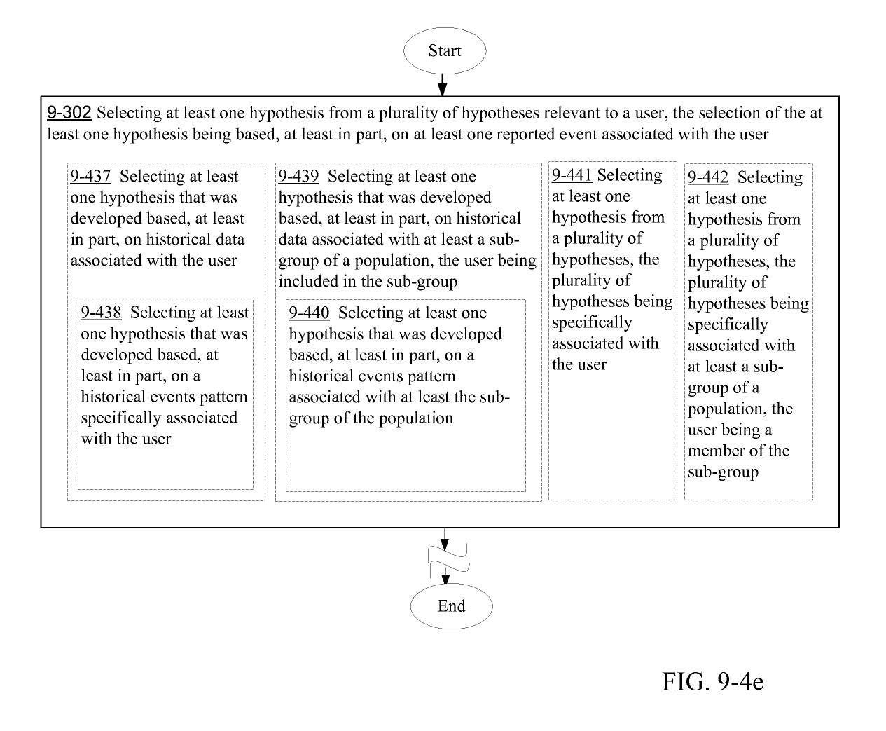

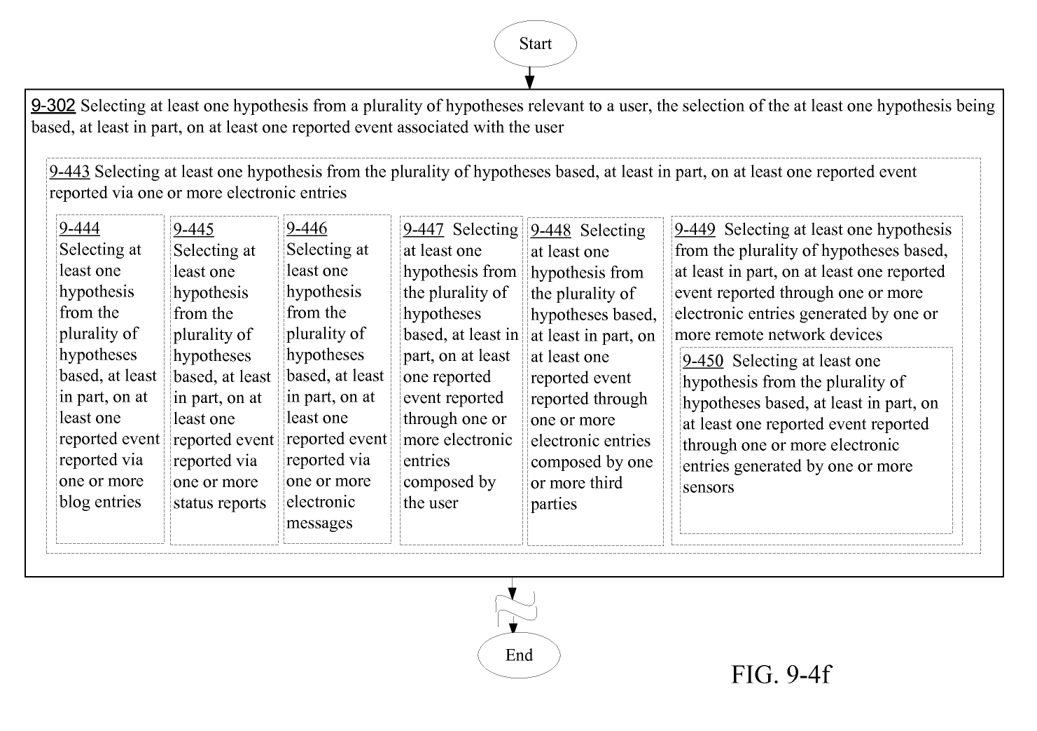

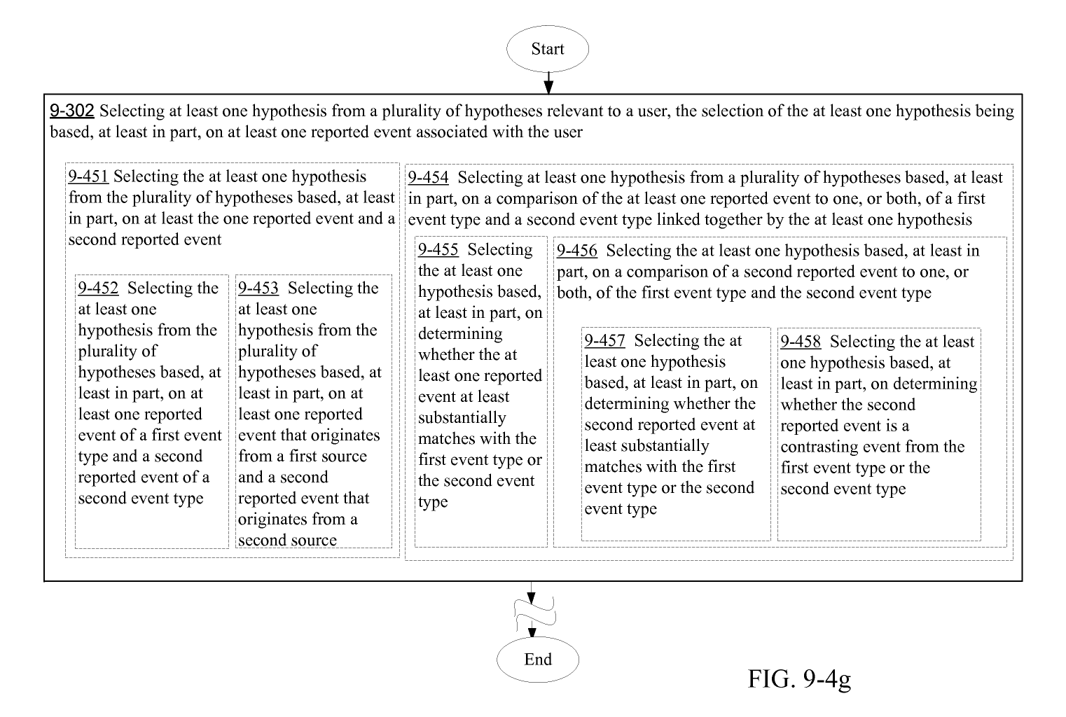

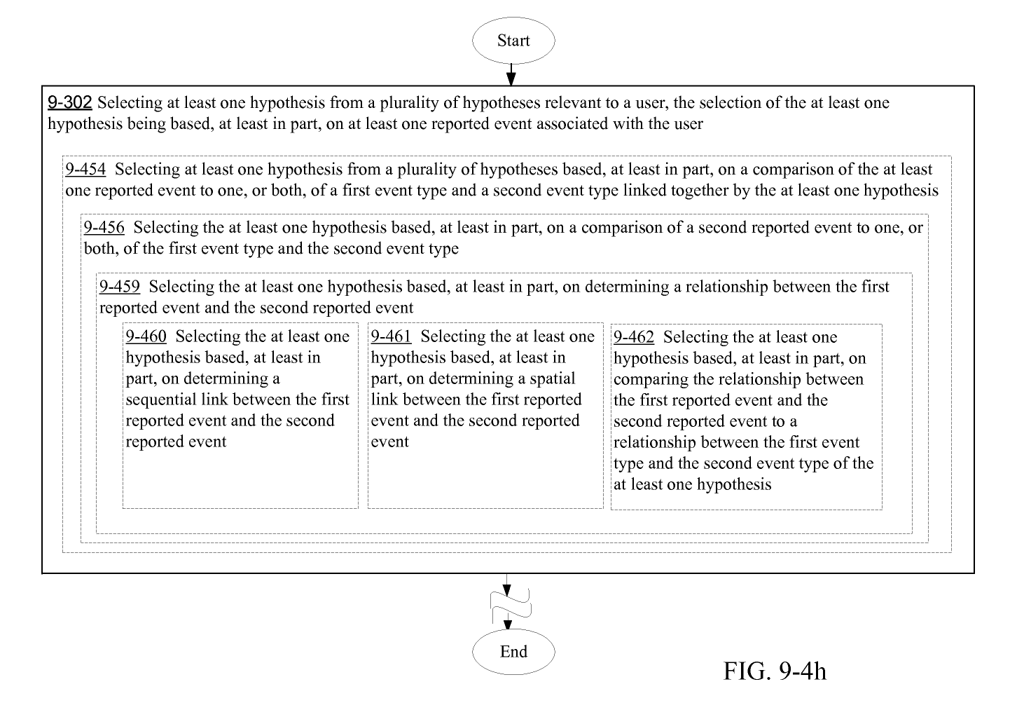

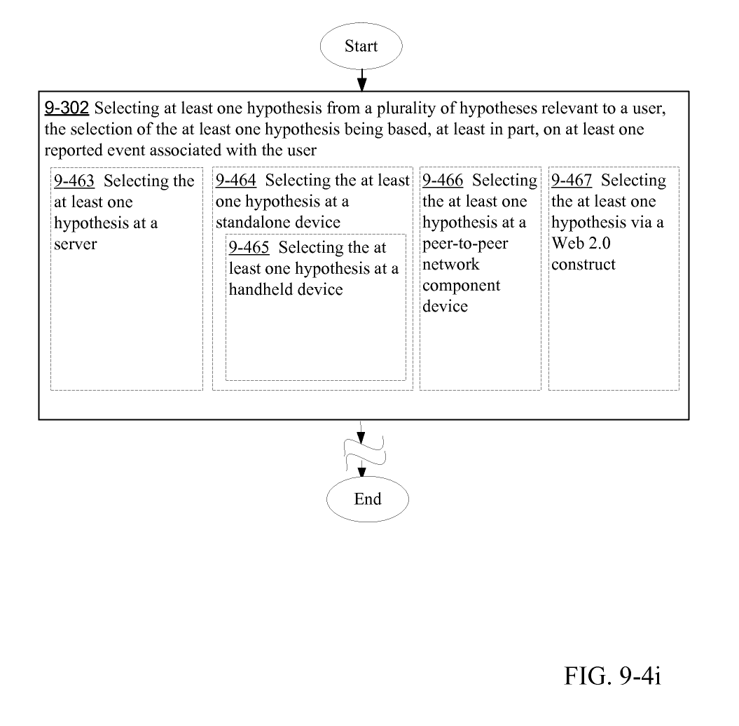

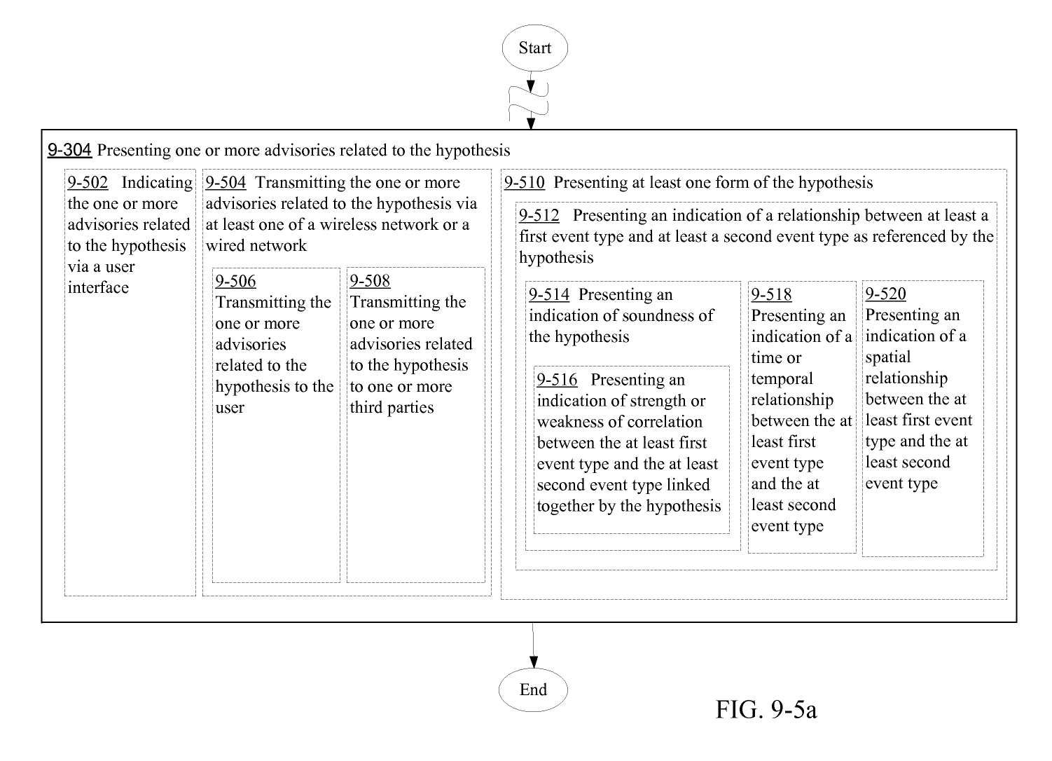

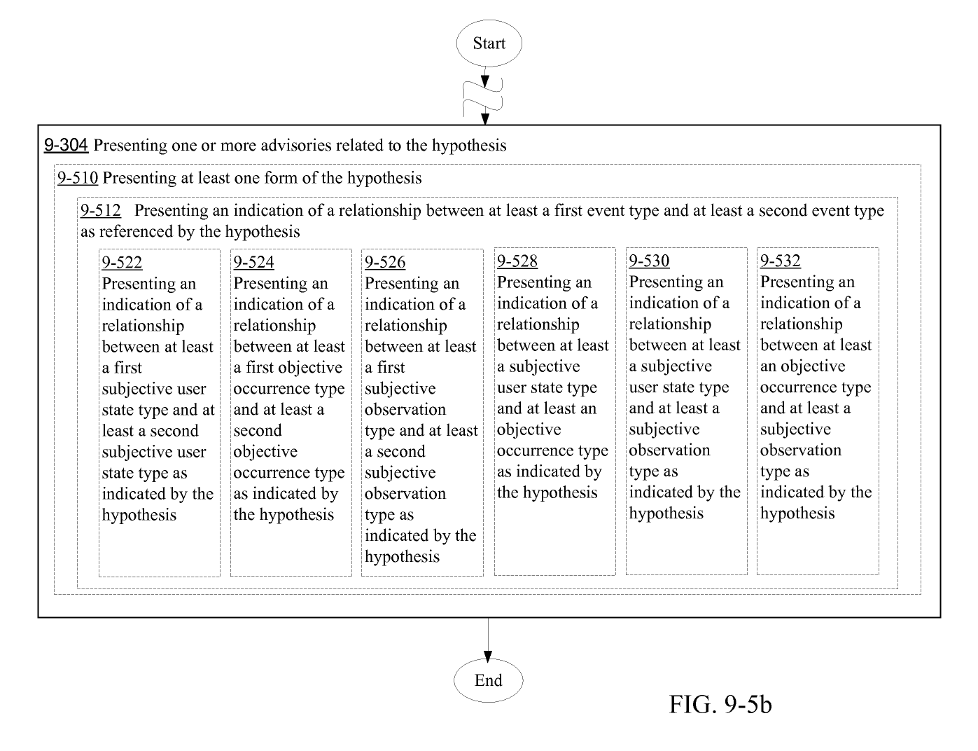

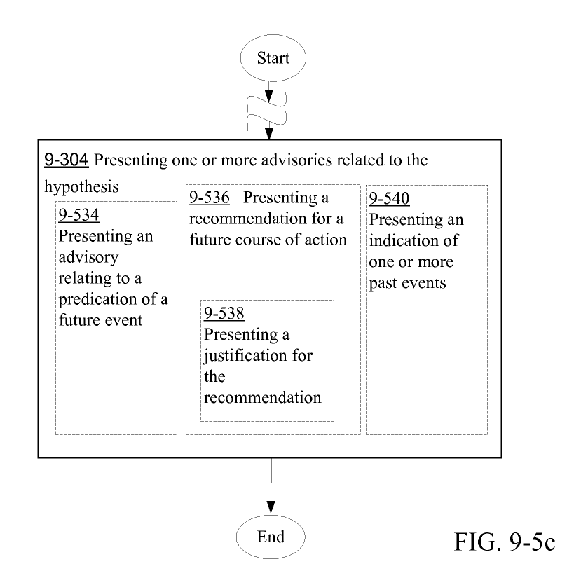

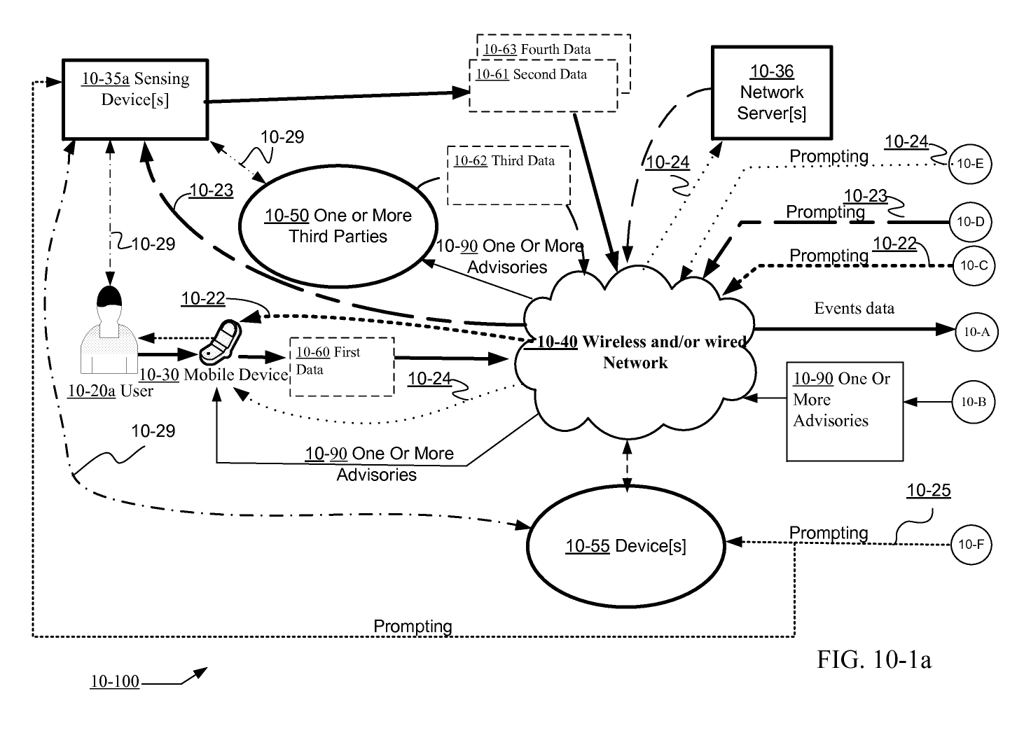

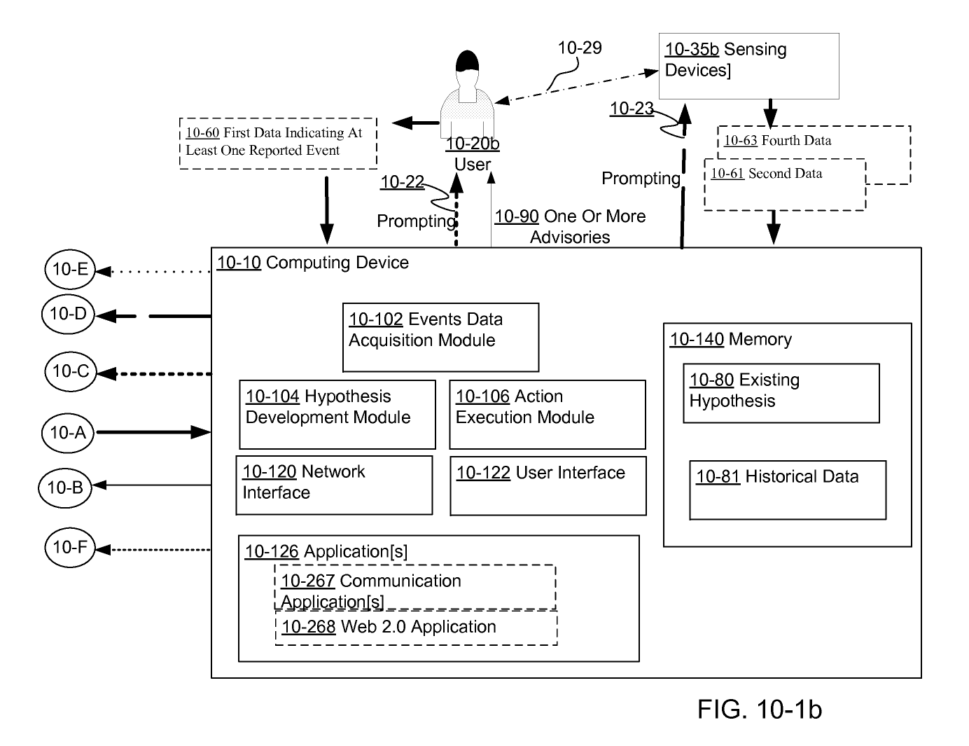

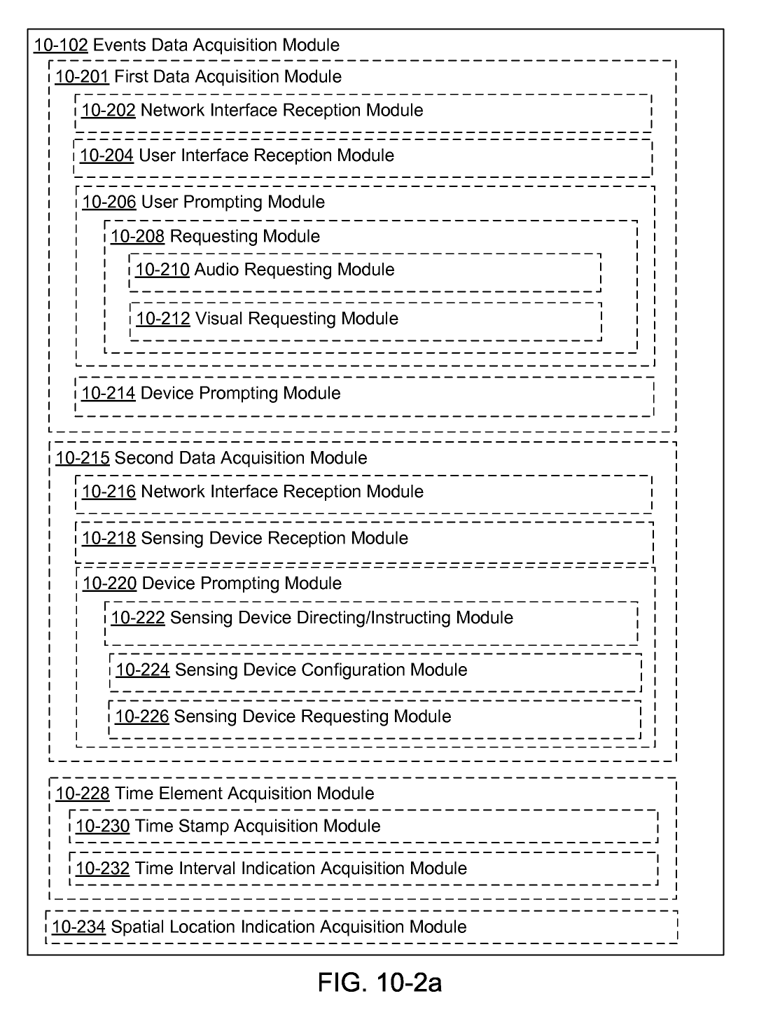

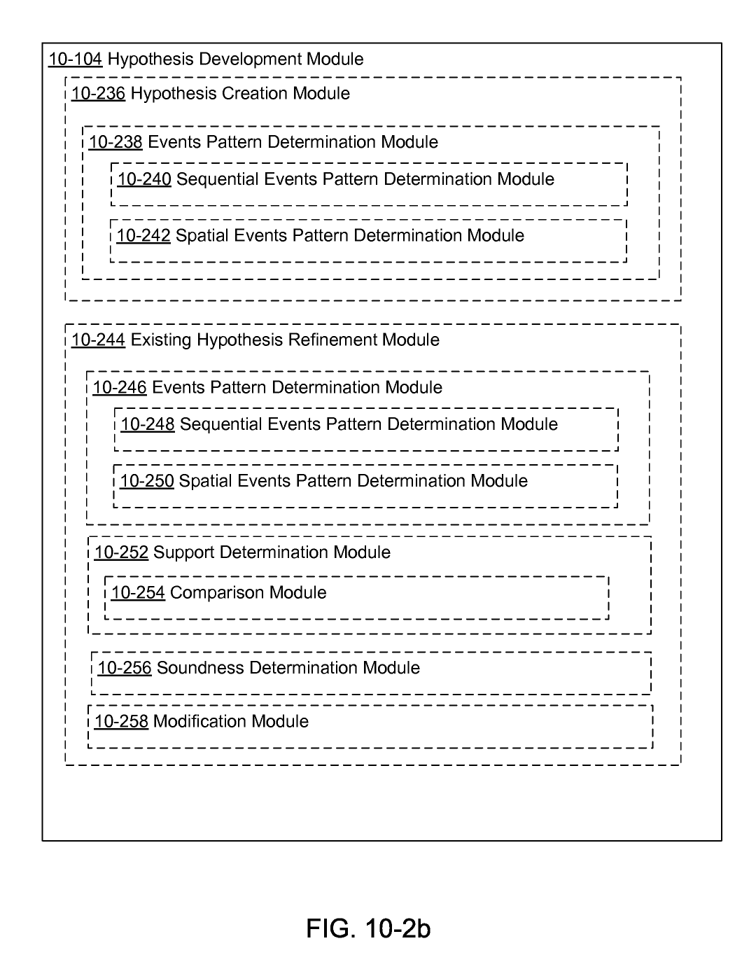

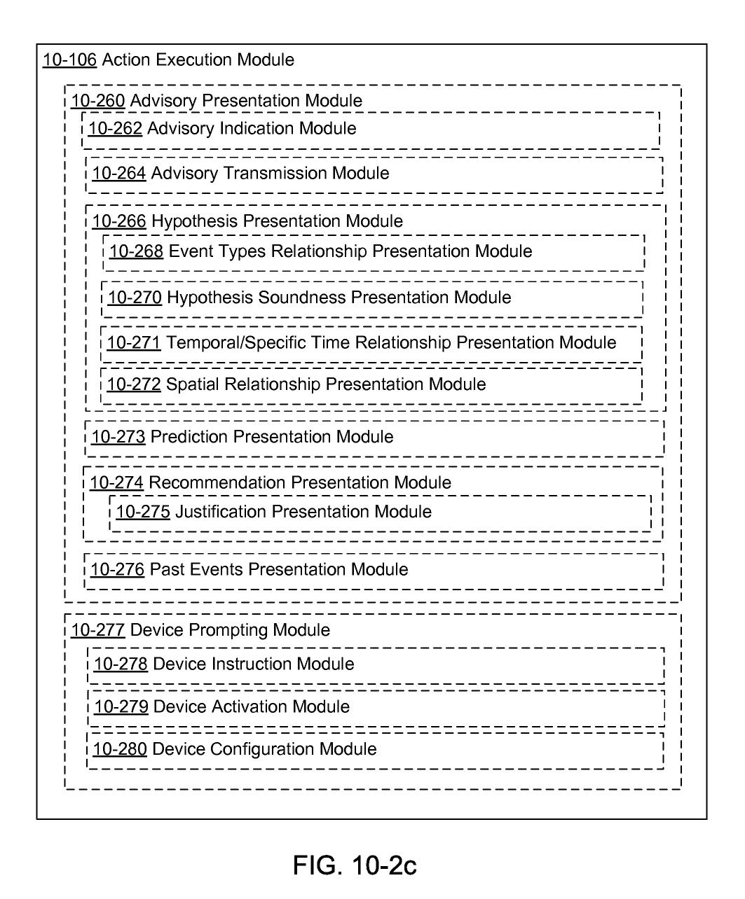

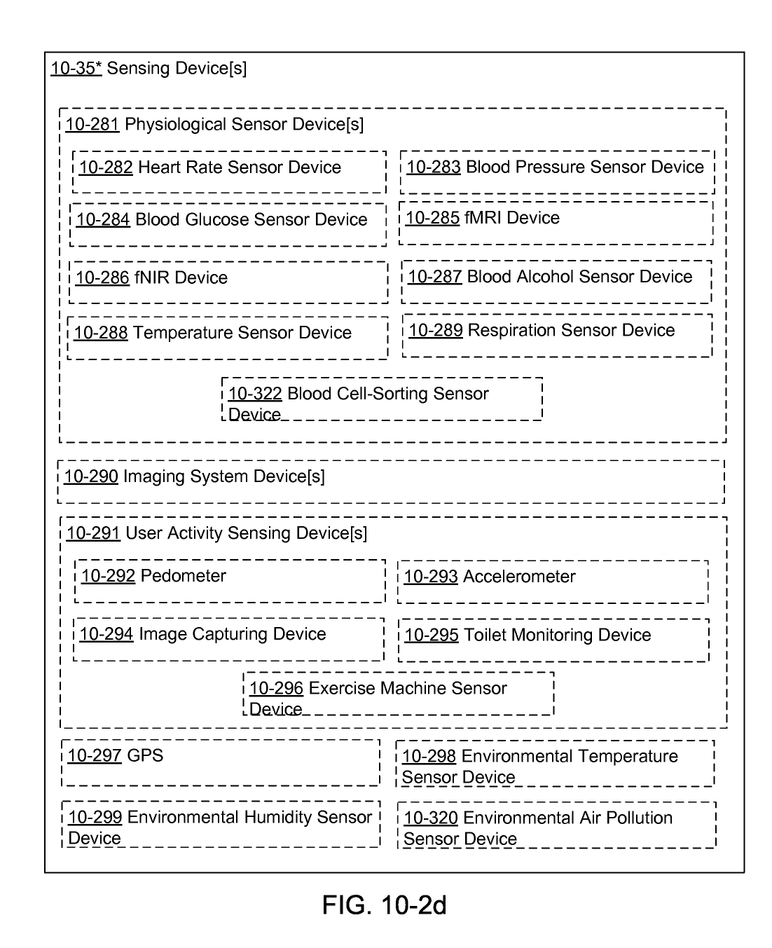

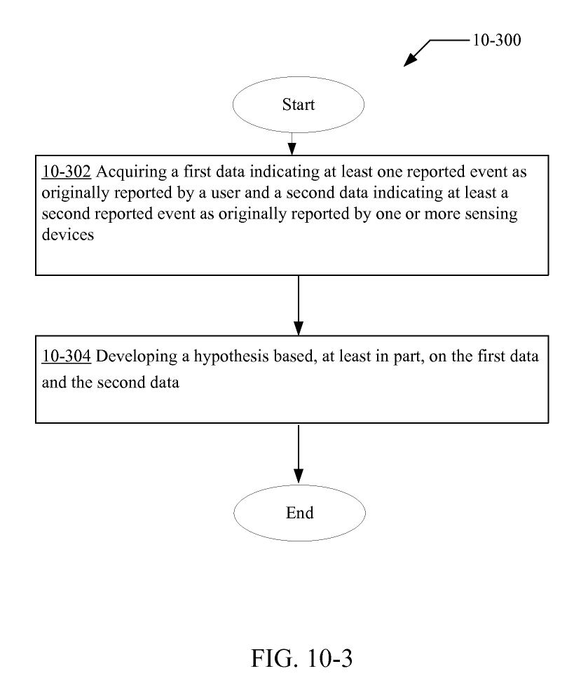

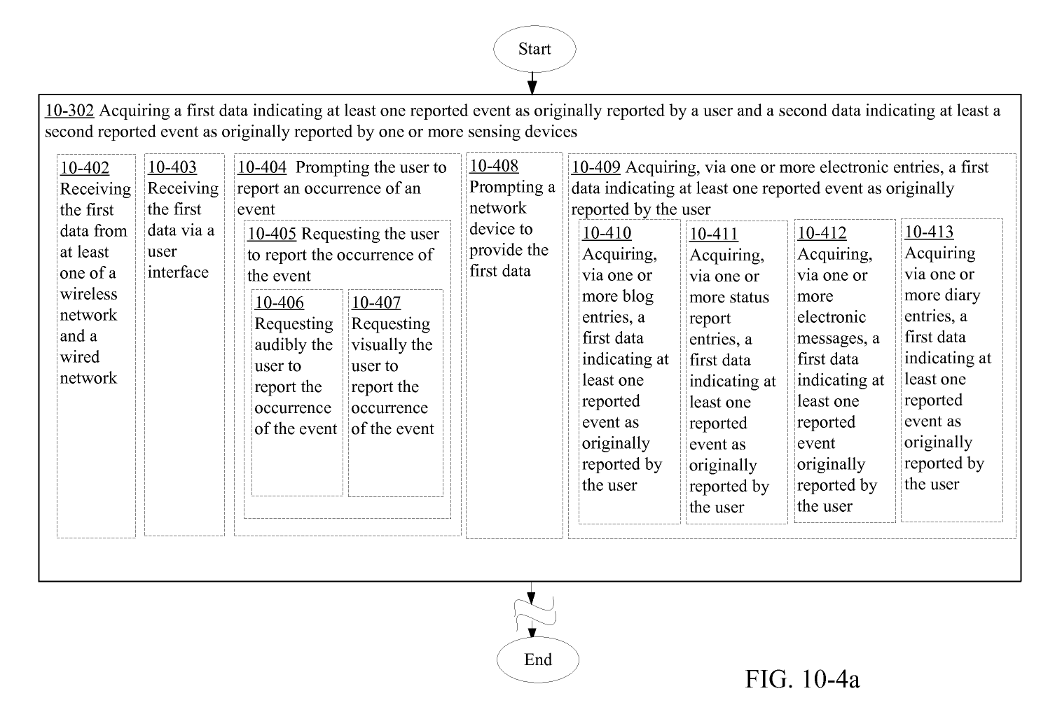

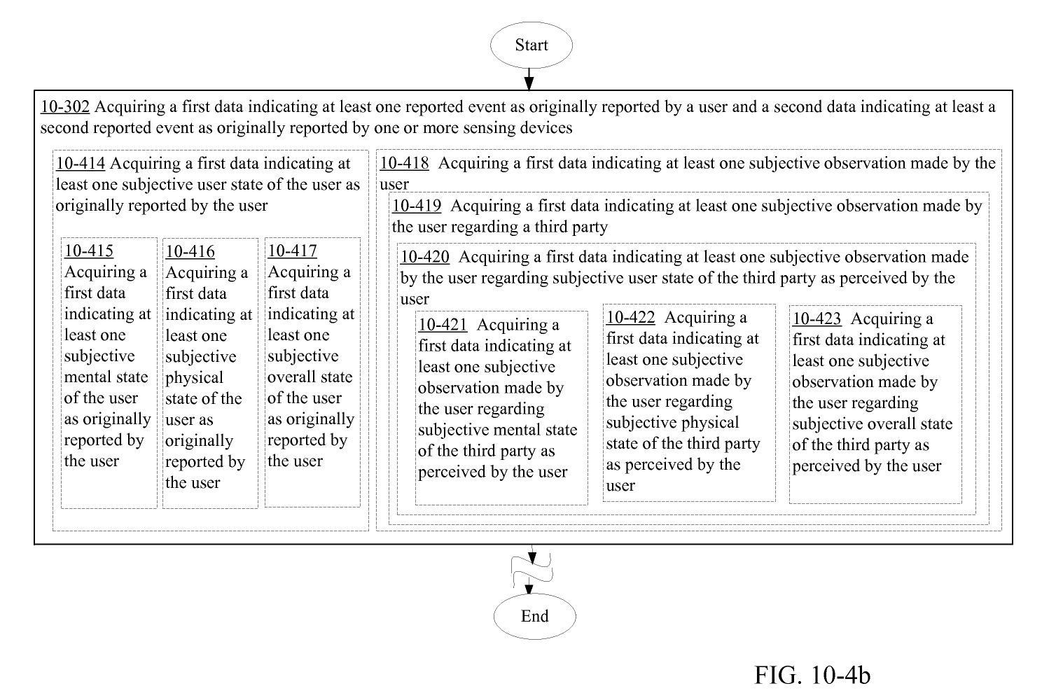

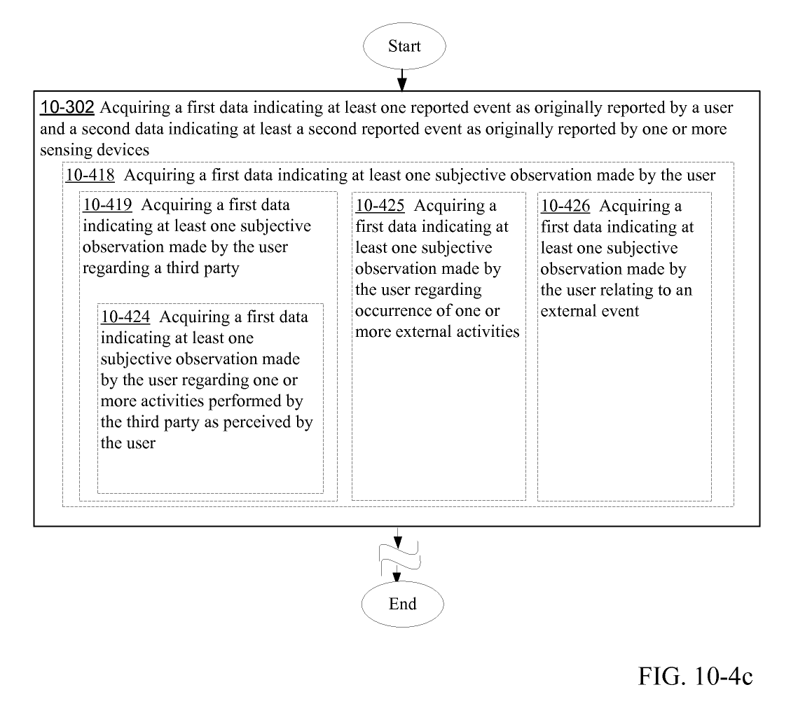

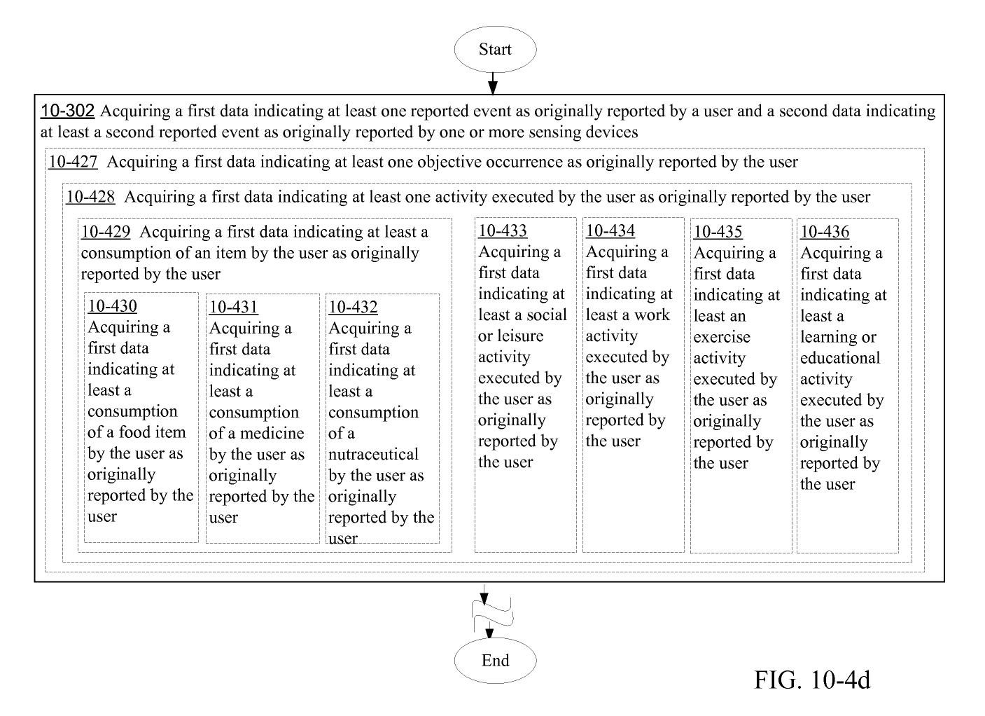

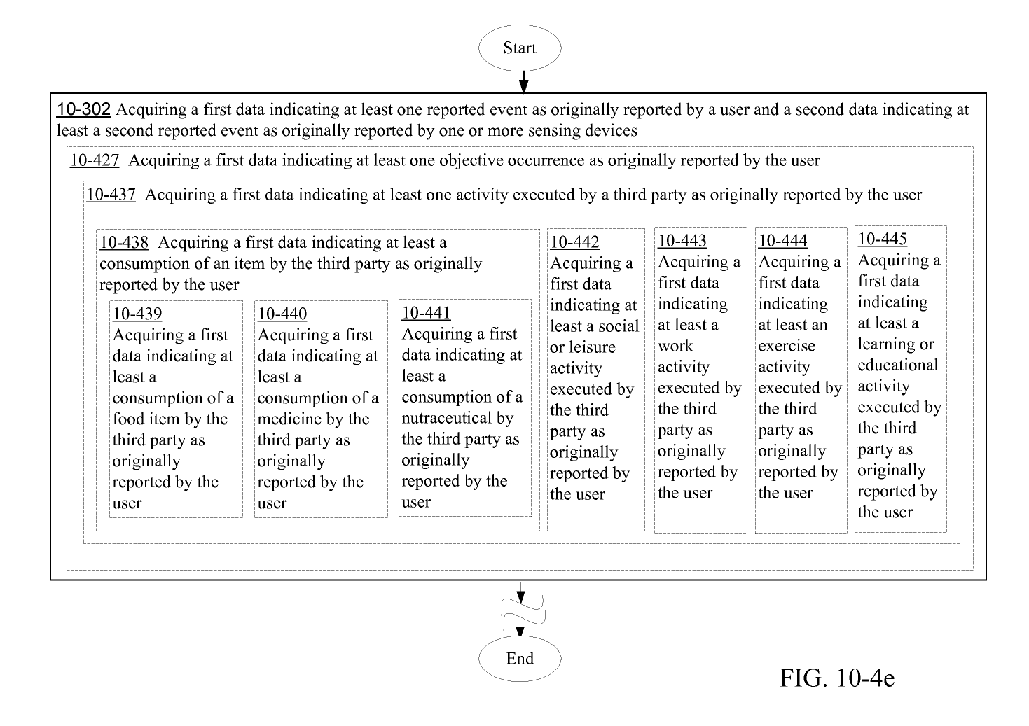

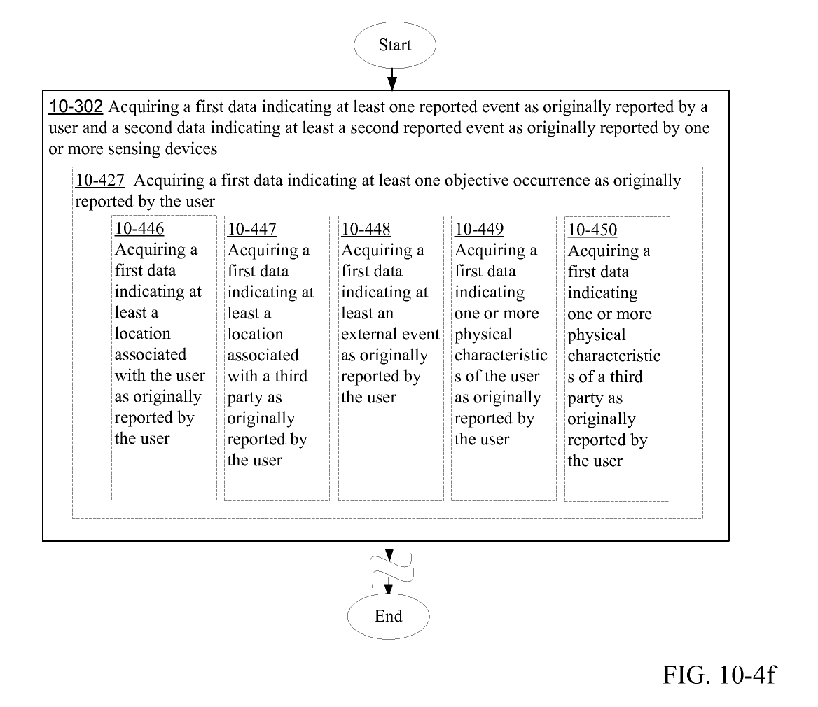

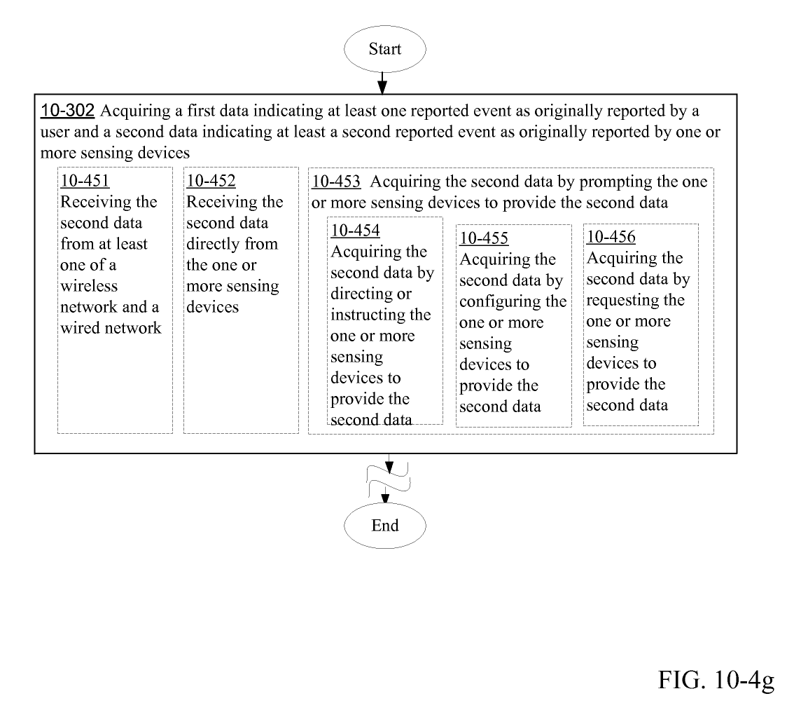

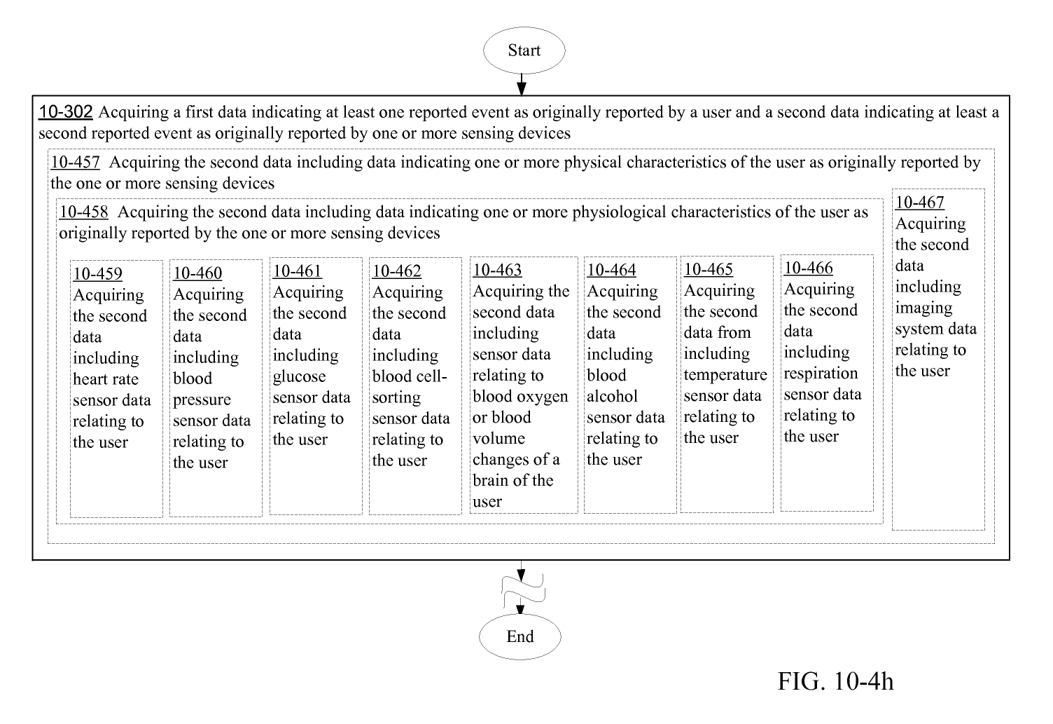

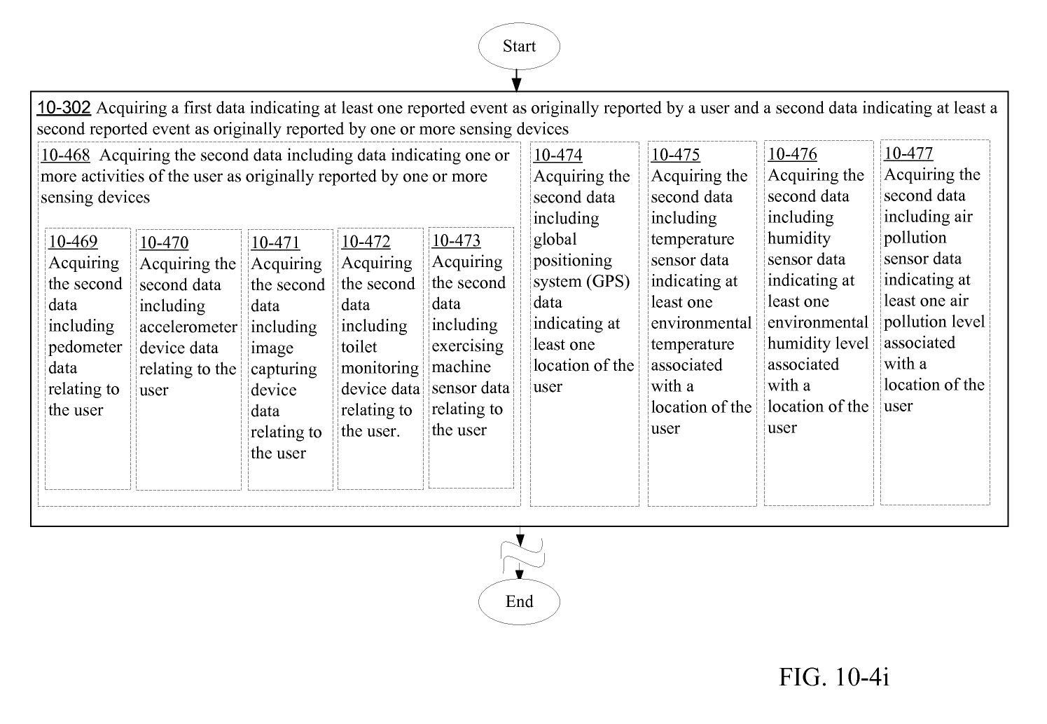

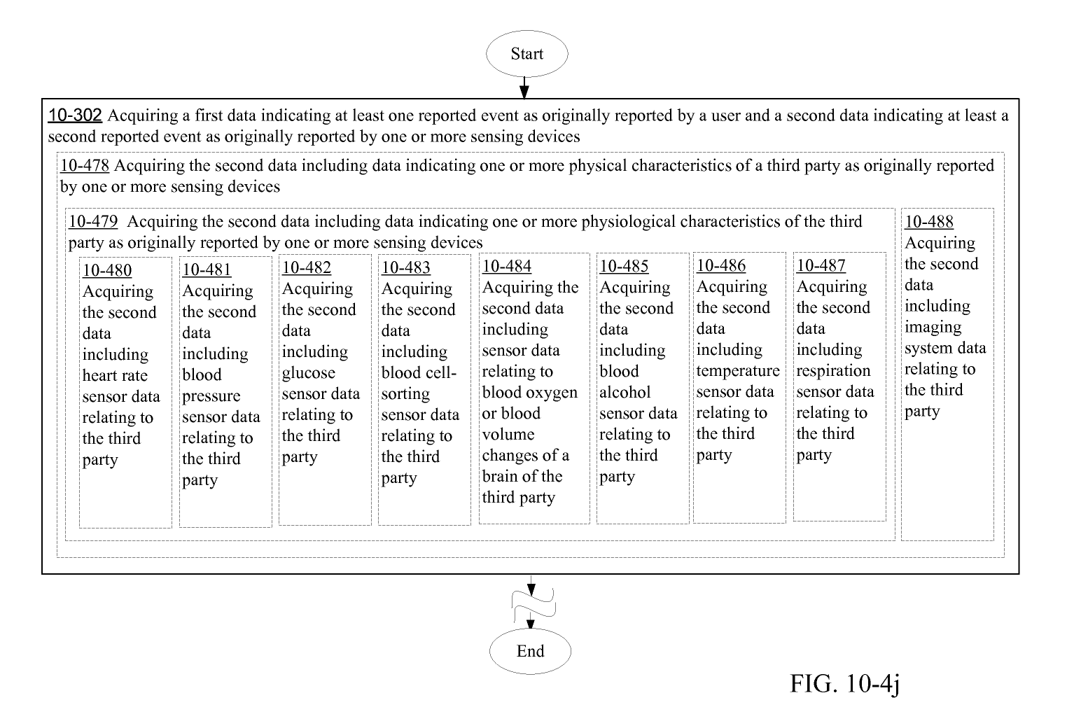

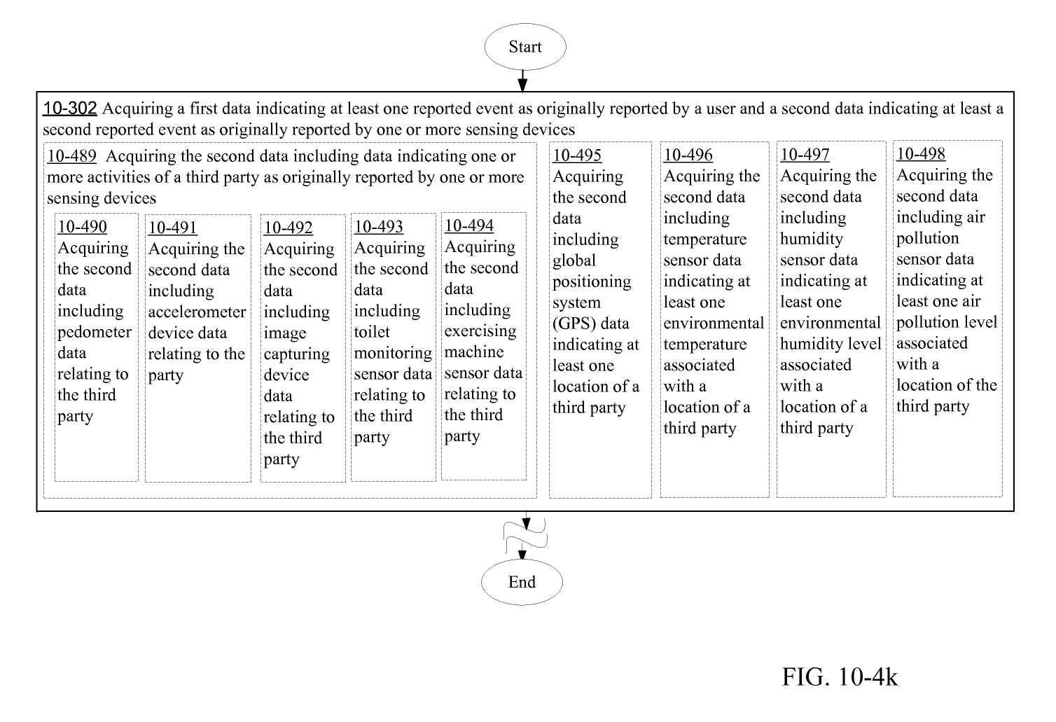

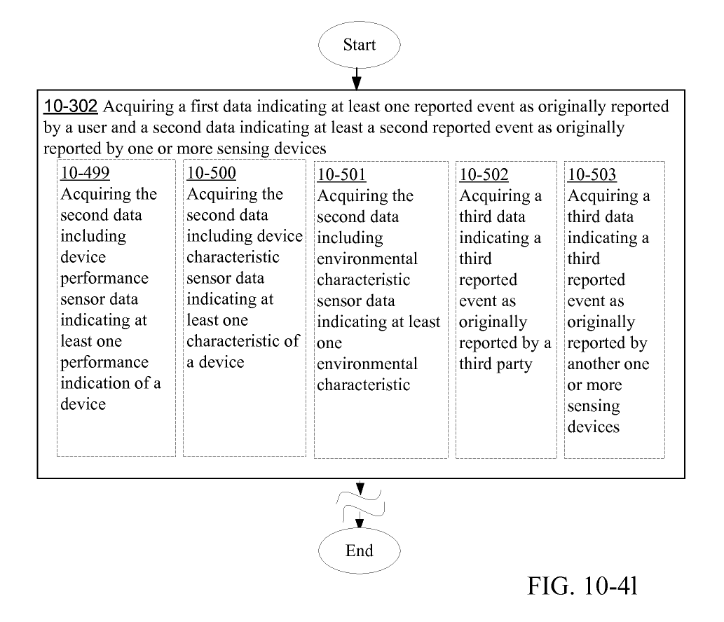

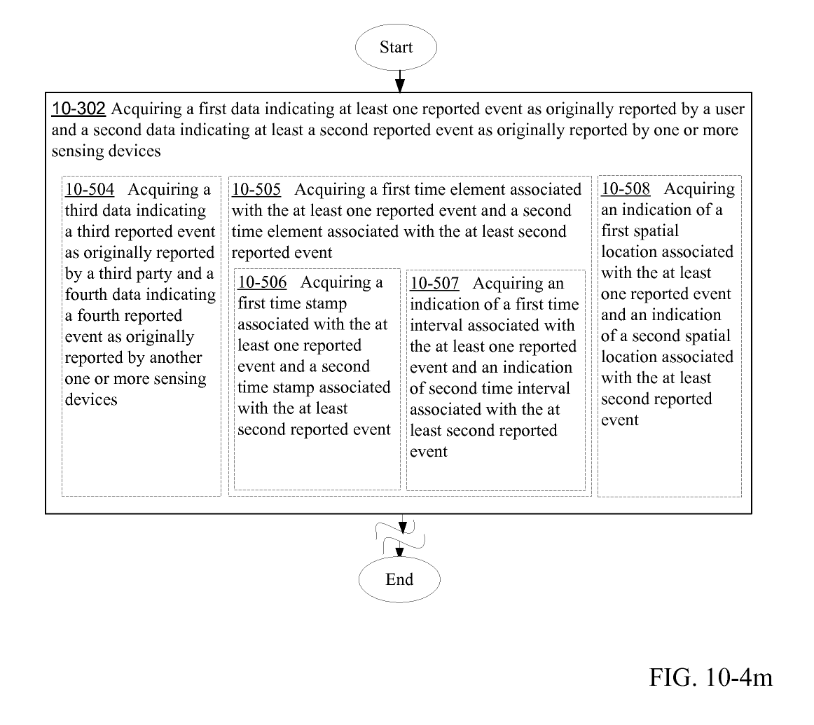

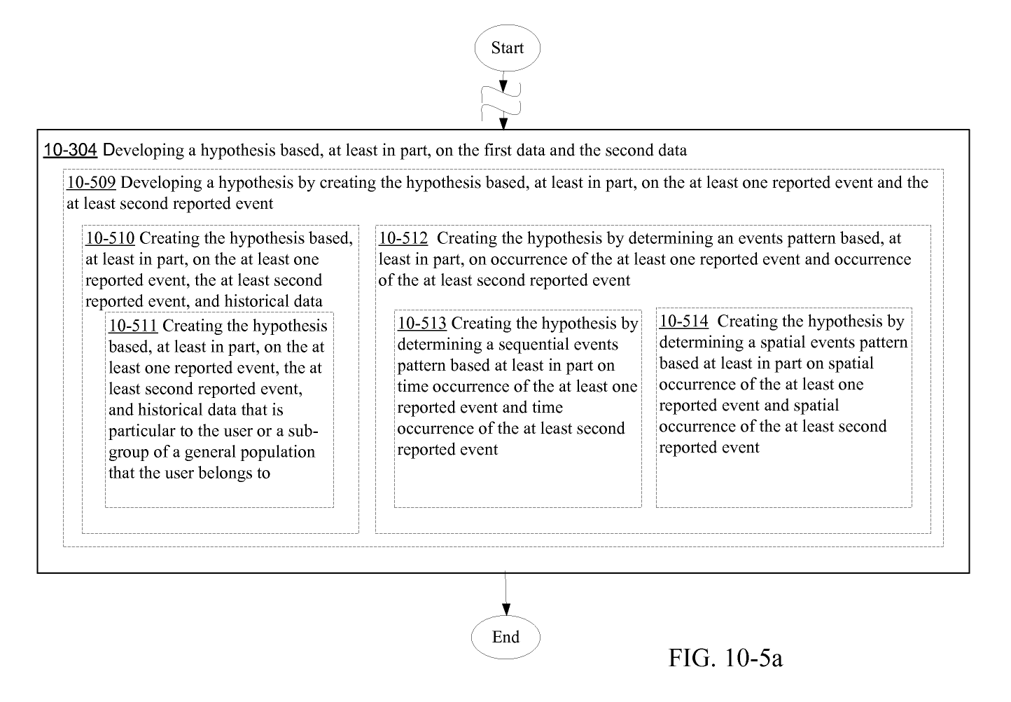

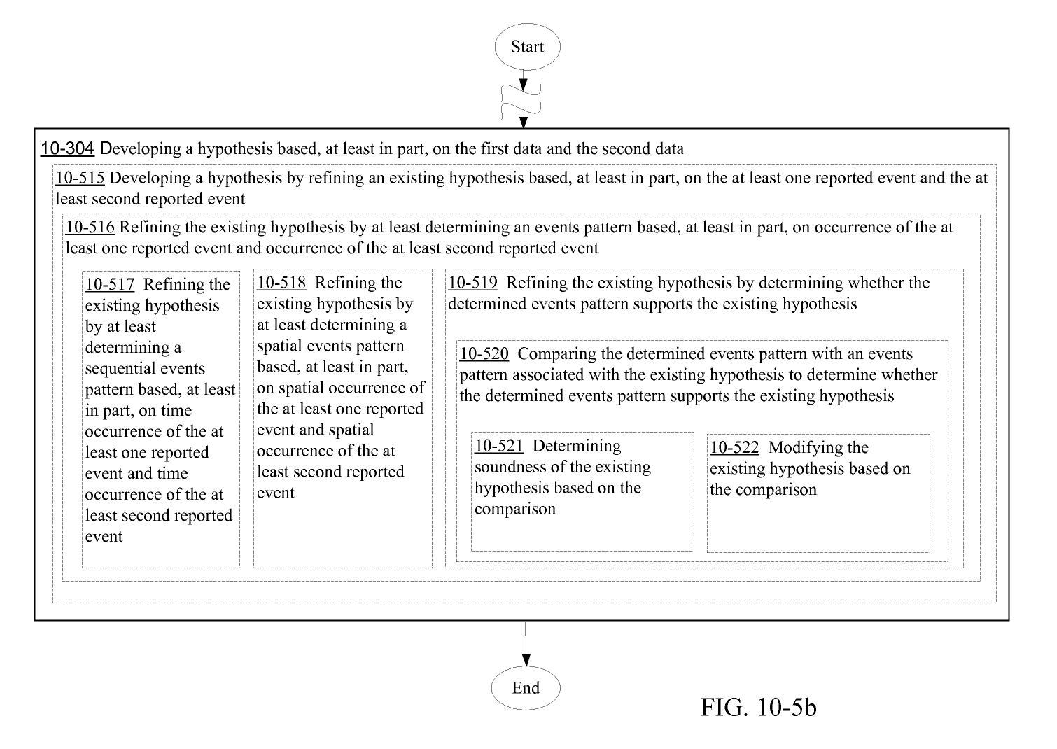

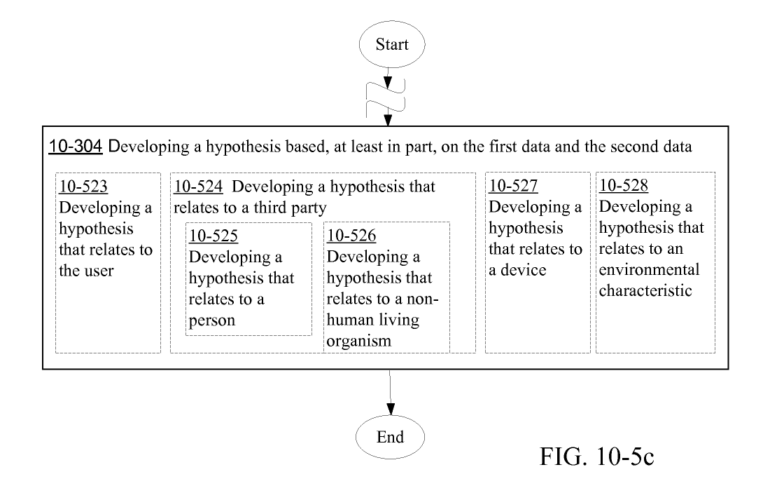

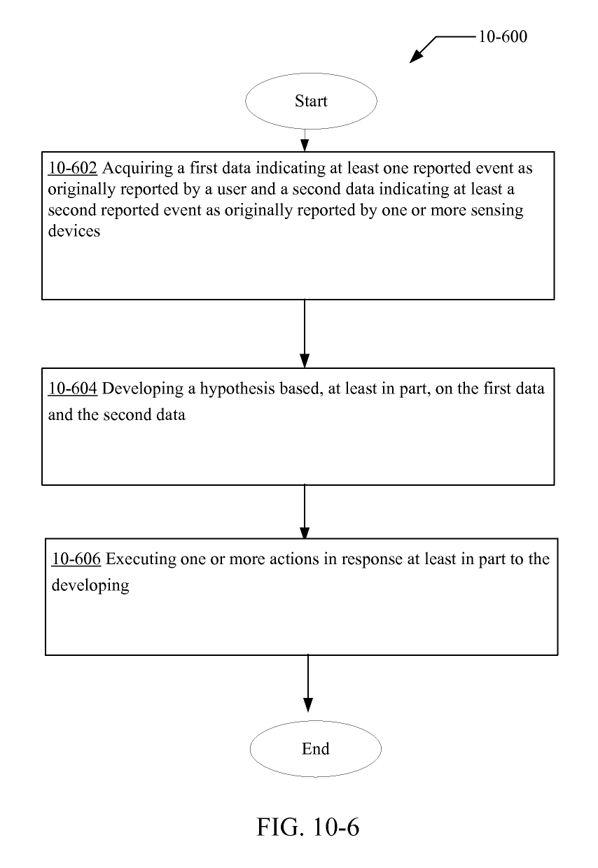

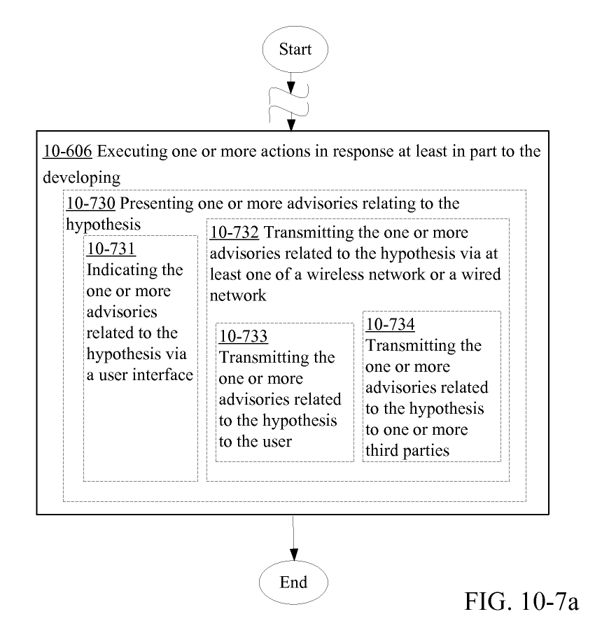

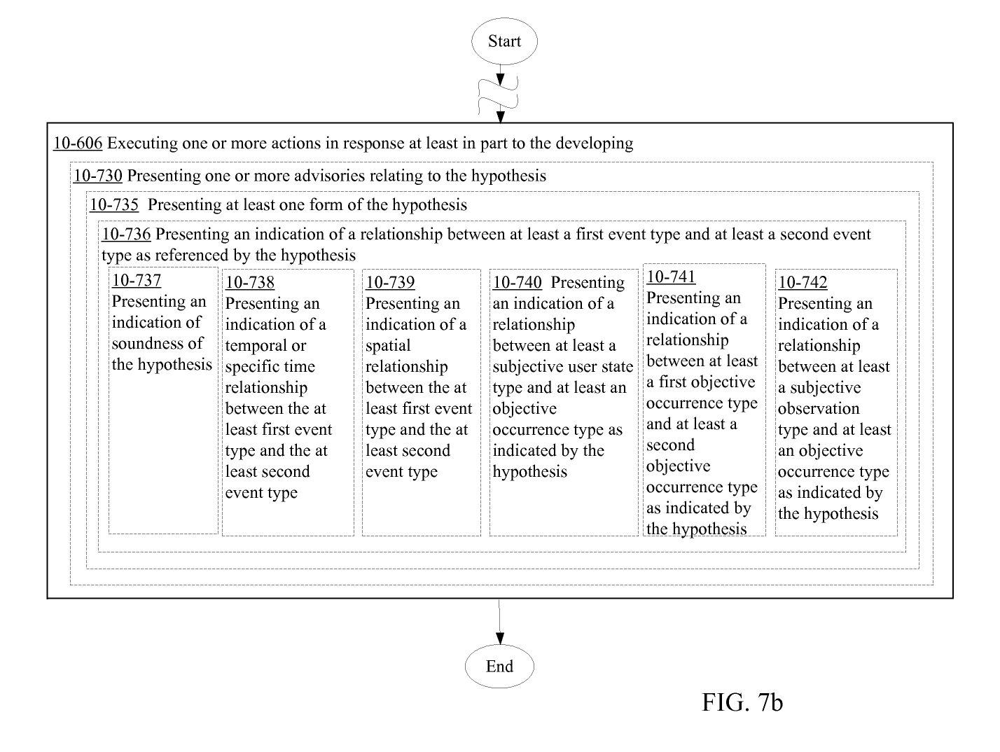

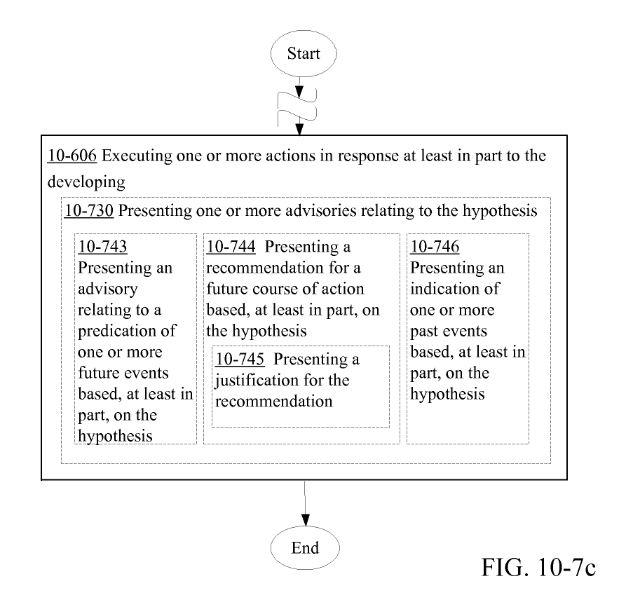

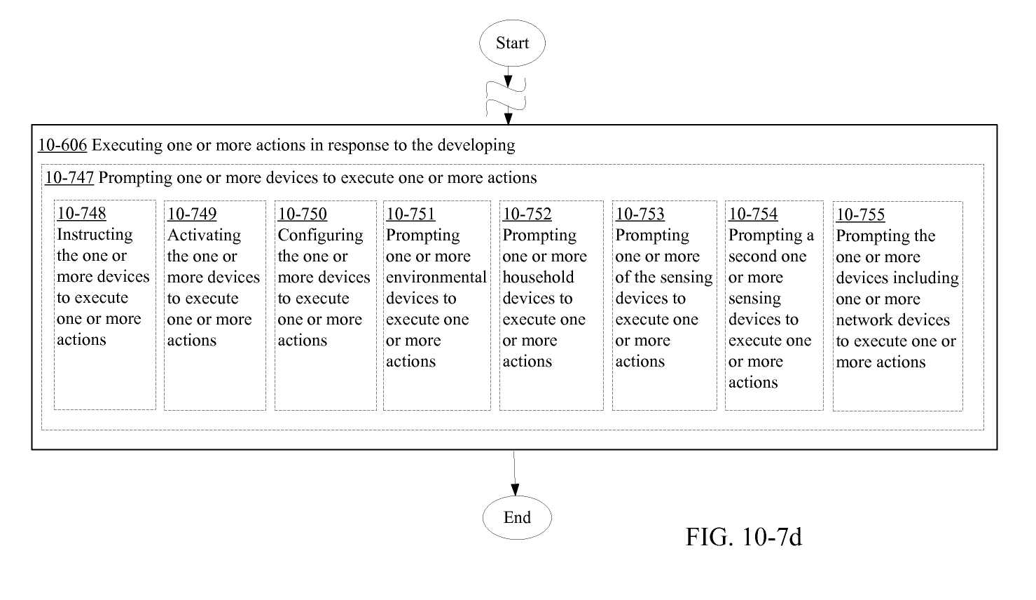

FIG. 5-6a is a high-level logic flowchart of a process depicting alternate implementations of the correlation operation 5-306 of FIG. 5-3.

FIG. 5-6b is a high-level logic flowchart of a process depicting alternate implementations of the correlation operation 5-306 of FIG. 5-3.

FIG. 5-6c is a high-level logic flowchart of a process depicting alternate implementations of the correlation operation 5-306 of FIG. 5-3.

FIG. 5-6d is a high-level logic flowchart of a process depicting alternate implementations of the correlation operation 5-306 of FIG. 5-3.

FIG. 5-6e is a high-level logic flowchart of a process depicting alternate implementations of the correlation operation 5-306 of FIG. 5-3.

FIG. 5-7 is a high-level logic flowchart of another process.

FIG. 5-8 is a high-level logic flowchart of a process depicting alternate implementations of the presentation operation 5-708 of FIG. 5-7.

FIGS. 6-1a and 6-1b show a high-level block diagram of a mobile device 6-30 and a computing device 6-10 operating in a network environment.

FIG. 6-2a shows another perspective of the subjective user state data solicitation module 6-101 of the computing device 6-10 of FIG. 6-1b.

FIG. 6-2b shows another perspective of the subjective user state data acquisition module 6-102 of the computing device 6-10 of FIG. 6-1b.

FIG. 6-2c shows another perspective of the objective occurrence data acquisition module 6-104 of the computing device 6-10 of FIG. 6-1b.

FIG. 6-2d shows another perspective of the correlation module 6-106 of the computing device 6-10 of FIG. 6-1b.

FIG. 6-2e shows another perspective of the presentation module 6-108 of the computing device 6-10 of FIG. 6-1b.

FIG. 6-2f shows another perspective of the one or more applications 6-126 of the computing device 6-10 of FIG. 6-1b.

FIG. 6-2g shows another perspective of the mobile device 6-30 of FIG. 6-1b.

FIG. 6-2h shows another perspective of the subjective user state data solicitation module 6-101′ of the mobile device 6-30 of FIG. 6-2g.

FIG. 6-2i shows another perspective of the subjective user state data acquisition module 6-102′ of the mobile device 6-30 of FIG. 6-2g.

FIG. 6-2j shows another perspective of the objective occurrence data acquisition module 6-104′ of the mobile device 6-30 of FIG. 6-2g.

FIG. 6-2k shows another perspective of the presentation module 6-108′ of the mobile device 6-30 of FIG. 6-2g.

FIG. 6-3 is a high-level logic flowchart of a process.

FIG. 6-4a is a high-level logic flowchart of a process depicting alternate implementations of the subjective user state data solicitation operation 6-302 of FIG. 6-3.

FIG. 6-4b is a high-level logic flowchart of a process depicting alternate implementations of the subjective user state data solicitation operation 6-302 of FIG. 6-3.

FIG. 6-4c is a high-level logic flowchart of a process depicting alternate implementations of the subjective user state data solicitation operation 6-302 of FIG. 6-3.

FIG. 6-4d is a high-level logic flowchart of a process depicting alternate implementations of the subjective user state data solicitation operation 6-302 of FIG. 6-3.

FIG. 6-4e is a high-level logic flowchart of a process depicting alternate implementations of the subjective user state data solicitation operation 6-302 of FIG. 6-3.

FIG. 6-4f is a high-level logic flowchart of a process depicting alternate implementations of the subjective user state data solicitation operation 6-302 of FIG. 6-3.

FIG. 6-4g is a high-level logic flowchart of a process depicting alternate implementations of the subjective user state data solicitation operation 6-302 of FIG. 6-3.

FIG. 6-5a is a high-level logic flowchart of a process depicting alternate implementations of the subjective user state data acquisition operation 6-304 of FIG. 6-3.

FIG. 6-5b is a high-level logic flowchart of a process depicting alternate implementations of the subjective user state data acquisition operation 6-304 of FIG. 6-3.

FIG. 6-6 is a high-level logic flowchart of another process.

FIG. 6-7a is a high-level logic flowchart of a process depicting alternate implementations of the objective occurrence data acquisition operation 6-606 of FIG. 6-6.

FIG. 6-7b is a high-level logic flowchart of a process depicting alternate implementations of the objective occurrence data acquisition operation 6-606 of FIG. 6-6.

FIG. 6-8 is a high-level logic flowchart of still another process.

FIG. 6-9 is a high-level logic flowchart of a process depicting alternate implementations of the correlation operation 6-808 of FIG. 6-8.

FIG. 6-10 is a high-level logic flowchart of a process depicting alternate implementations of the presentation operation 6-810 of FIG. 6-8.

FIG. 6-11 is a high-level logic flowchart of still another process.

FIG. 6-12 is a high-level logic flowchart of a process depicting alternate implementations of the subjective user state data transmission operation 6-1106 of FIG. 6-11.

FIG. 6-13 is a high-level logic flowchart of a process depicting alternate implementations of the reception operation 6-1108 of FIG. 6-11.

FIG. 6-14 is a high-level logic flowchart of a process depicting alternate implementations of the presentation operation 6-1110 of FIG. 6-11.

FIGS. 7-1a and 7-1b show a high-level block diagram of a mobile device 7-30 and a computing device 7-10 operating in a network environment.

FIG. 7-2a shows another perspective of the objective occurrence data solicitation module 7-101 of the computing device 7-10 of FIG. 7-1b.

FIG. 7-2b shows another perspective of the subjective user state data acquisition module 7-102 of the computing device 7-10 of FIG. 7-1b.

FIG. 7-2c shows another perspective of the objective occurrence data acquisition module 7-104 of the computing device 7-10 of FIG. 7-1b.

FIG. 7-2d shows another perspective of the correlation module 7-106 of the computing device 7-10 of FIG. 7-1b.

FIG. 7-2e shows another perspective of the presentation module 7-108 of the computing device 7-10 of FIG. 7-1b.

FIG. 7-2f shows another perspective of the one or more applications 7-126 of the computing device 7-10 of FIG. 7-1b.

FIG. 7-2g shows another perspective of the mobile device 7-30 of FIG. 7-1a.

FIG. 7-2h shows another perspective of the objective occurrence data solicitation module 7-101′ of the mobile device 7-30 of FIG. 7-2g.

FIG. 7-2i shows another perspective of the subjective user state data acquisition module 7-102′ of the mobile device 7-30 of FIG. 7-2g.

FIG. 7-2j shows another perspective of the objective occurrence data acquisition module 7-104′ of the mobile device 7-30 of FIG. 7-2g.

FIG. 7-2k shows another perspective of the presentation module 7-108′ of the mobile device 7-30 of FIG. 7-2g.

FIG. 7-2l shows another perspective of the one or more applications 7-126′ of the mobile device 7-30 of FIG. 7-2g.

FIG. 7-3 is a high-level logic flowchart of a process.

FIG. 7-4a is a high-level logic flowchart of a process depicting alternate implementations of the objective occurrence data solicitation operation 7-302 of FIG. 7-3.

FIG. 7-4b is a high-level logic flowchart of a process depicting alternate implementations of the objective occurrence data solicitation operation 7-302 of FIG. 7-3.

FIG. 7-4c is a high-level logic flowchart of a process depicting alternate implementations of the objective occurrence data solicitation operation 7-302 of FIG. 7-3.

FIG. 7-4d is a high-level logic flowchart of a process depicting alternate implementations of the objective occurrence data solicitation operation 7-302 of FIG. 7-3.

FIG. 7-4e is a high-level logic flowchart of a process depicting alternate implementations of the objective occurrence data solicitation operation 7-302 of FIG. 7-3.

FIG. 7-4f is a high-level logic flowchart of a process depicting alternate implementations of the objective occurrence data solicitation operation 7-302 of FIG. 7-3.

FIG. 7-4g is a high-level logic flowchart of a process depicting alternate implementations of the objective occurrence data solicitation operation 7-302 of FIG. 7-3.

FIG. 7-4h is a high-level logic flowchart of a process depicting alternate implementations of the objective occurrence data solicitation operation 7-302 of FIG. 7-3.

FIG. 7-4i is a high-level logic flowchart of a process depicting alternate implementations of the objective occurrence data solicitation operation 7-302 of FIG. 7-3.

FIG. 7-4j is a high-level logic flowchart of a process depicting alternate implementations of the objective occurrence data solicitation operation 7-302 of FIG. 7-3.

FIG. 7-5a is a high-level logic flowchart of a process depicting alternate implementations of the objective occurrence data acquisition operation 7-304 of FIG. 7-3.

FIG. 7-5b is a high-level logic flowchart of a process depicting alternate implementations of the objective occurrence data acquisition operation 7-304 of FIG. 7-3.

FIG. 7-5c is a high-level logic flowchart of a process depicting alternate implementations of the objective occurrence data acquisition operation 7-304 of FIG. 7-3.

FIG. 7-5d is a high-level logic flowchart of a process depicting alternate implementations of the objective occurrence data acquisition operation 7-304 of FIG. 7-3.

FIG. 7-6 is a high-level logic flowchart of another process.

FIG. 7-7a is a high-level logic flowchart of a process depicting alternate implementations of the subjective user state data acquisition operation 7-606 of FIG. 7-6.

FIG. 7-7b is a high-level logic flowchart of a process depicting alternate implementations of the subjective user state data acquisition operation 7-606 of FIG. 7-6.

FIG. 7-8 is a high-level logic flowchart of still another process.

FIG. 7-9 is a high-level logic flowchart of a process depicting alternate implementations of the correlation operation 7-808 of FIG. 7-8.

FIG. 7-10 is a high-level logic flowchart of a process depicting alternate implementations of the presentation operation 7-810 of FIG. 7-8.

FIG. 7-11 is a high-level logic flowchart of still another process.

FIG. 7-12 is a high-level logic flowchart of a process depicting alternate implementations of the objective occurrence data transmission operation 7-1106 of FIG. 7-11.

FIG. 7-13 is a high-level logic flowchart of a process depicting alternate implementations of the reception operation 7-1108 of FIG. 7-11.

FIG. 7-14 is a high-level logic flowchart of a process depicting alternate implementations of the presentation operation 7-1110 of FIG. 7-11.

FIGS. 8-1a and 8-1b show a high-level block diagram of a mobile device 8-30 and a computing device 8-10 operating in a network environment.

FIG. 8-2a shows another perspective of the events data acquisition module 8-102 of the computing device 8-10 of FIG. 8-1b.

FIG. 8-2b shows another perspective of the events pattern determination module 8-104 of the computing device 8-10 of FIG. 8-1b.

FIG. 8-2c shows another perspective of the hypothesis development module 8-106 of the computing device 8-10 of FIG. 8-1b.

FIG. 8-2d shows another perspective of the action execution module 8-108 of the computing device 8-10 of FIG. 8-1b.

FIG. 8-2e shows another perspective of the one or more applications 8-126 of the computing device 8-10 of FIG. 8-1b.

FIG. 8-3 is a high-level logic flowchart of a process.

FIG. 8-4a is a high-level logic flowchart of a process depicting alternate implementations of the events data acquisition operation 8-302 of FIG. 8-3.

FIG. 8-4b is a high-level logic flowchart of a process depicting alternate implementations of the events data acquisition operation 8-302 of FIG. 8-3.

FIG. 8-4c is a high-level logic flowchart of a process depicting alternate implementations of the events data acquisition operation 8-302 of FIG. 8-3.

FIG. 8-4d is a high-level logic flowchart of a process depicting alternate implementations of the events data acquisition operation 8-302 of FIG. 8-3.

FIG. 8-4e is a high-level logic flowchart of a process depicting alternate implementations of the events data acquisition operation 8-302 of FIG. 8-3.

FIG. 8-4f is a high-level logic flowchart of a process depicting alternate implementations of the events data acquisition operation 8-302 of FIG. 8-3.

FIG. 8-4g is a high-level logic flowchart of a process depicting alternate implementations of the events data acquisition operation 8-302 of FIG. 8-3.

FIG. 8-4h is a high-level logic flowchart of a process depicting alternate implementations of the events data acquisition operation 8-302 of FIG. 8-3.

FIG. 8-4i is a high-level logic flowchart of a process depicting alternate implementations of the events data acquisition operation 8-302 of FIG. 8-3.

FIG. 8-5 is a high-level logic flowchart of a process depicting alternate implementations of the events pattern determination operation 8-304 of FIG. 8-3.

FIG. 8-6a is a high-level logic flowchart of a process depicting alternate implementations of the hypothesis development operation 8-306 of FIG. 8-3.

FIG. 8-6b is a high-level logic flowchart of a process depicting alternate implementations of the hypothesis development operation 8-306 of FIG. 8-3.

FIG. 8-7 is a high-level logic flowchart of another process.

FIG. 8-8a is a high-level logic flowchart of a process depicting alternate implementations of the action execution operation 8-708 of FIG. 8-7.

FIG. 8-8b is a high-level logic flowchart of a process depicting alternate implementations of the action execution operation 8-708 of FIG. 8-7.

FIGS. 9-1a and 9-1b show a high-level block diagram a computing device 9-10 operating in a network environment.

FIG. 9-2a shows another perspective of the events data acquisition module 9-102 of the computing device 9-10 of FIG. 9-1b.

FIG. 9-2b shows another perspective of the hypothesis selection module 9-104 of the computing device 9-10 of FIG. 9-1b.

FIG. 9-2c shows another perspective of the presentation module 9-106 of the computing device 9-10 of FIG. 9-1b.

FIG. 9-3 is a high-level logic flowchart of a process.

FIG. 9-4a is a high-level logic flowchart of a process depicting alternate implementations of the hypothesis selection operation 9-302 of FIG. 9-3.

FIG. 9-4b is a high-level logic flowchart of a process depicting alternate implementations of the hypothesis selection operation 9-302 of FIG. 9-3.

FIG. 9-4c is a high-level logic flowchart of a process depicting alternate implementations of the hypothesis selection operation 9-302 of FIG. 9-3.

FIG. 9-4d is a high-level logic flowchart of a process depicting alternate implementations of the hypothesis selection operation 9-302 of FIG. 9-3.

FIG. 9-4e is a high-level logic flowchart of a process depicting alternate implementations of the hypothesis selection operation 9-302 of FIG. 9-3.

FIG. 9-4f is a high-level logic flowchart of a process depicting alternate implementations of the hypothesis selection operation 9-302 of FIG. 9-3.

FIG. 9-4g is a high-level logic flowchart of a process depicting alternate implementations of the hypothesis selection operation 9-302 of FIG. 9-3.

FIG. 9-4h is a high-level logic flowchart of a process depicting alternate implementations of the hypothesis selection operation 9-302 of FIG. 9-3.

FIG. 9-4i is a high-level logic flowchart of a process depicting alternate implementations of the hypothesis selection operation 9-302 of FIG. 9-3.

FIG. 9-5a is a high-level logic flowchart of a process depicting alternate implementations of the advisory presentation operation 9-304 of FIG. 9-3.

FIG. 9-5b is a high-level logic flowchart of a process depicting alternate implementations of the advisory presentation operation 9-304 of FIG. 9-3.

FIG. 9-5c is a high-level logic flowchart of a process depicting alternate implementations of the advisory presentation operation 9-304 of FIG. 9-3.

FIGS. 10-1a and 10-1b show a high-level block diagram of a computing device 10-10 operating in a network environment.

FIG. 10-2a shows another perspective of the events data acquisition module 10-102 of the computing device 10-10 of FIG. 10-1b.

FIG. 10-2b shows another perspective of the hypothesis development module 10-104 of the computing device 10-10 of FIG. 10-1b.

FIG. 10-2c shows another perspective of the action execution module 10-106 of the computing device 10-10 of FIG. 10-1b.

FIG. 10-2d shows another perspective of the one or more sensing devices 10-35a and/or 10-35b of FIGS. 10-1a and 10-1b.

FIG. 10-3 is a high-level logic flowchart of a process.

FIG. 10-4a is a high-level logic flowchart of a process depicting alternate implementations of the data acquisition operation 10-302 of FIG. 10-3.

FIG. 10-4b is a high-level logic flowchart of a process depicting alternate implementations of the data acquisition operation 10-302 of FIG. 10-3.

FIG. 10-4c is a high-level logic flowchart of a process depicting alternate implementations of the data acquisition operation 10-302 of FIG. 10-3.

FIG. 10-4d is a high-level logic flowchart of a process depicting alternate implementations of the data acquisition operation 10-302 of FIG. 10-3.

FIG. 10-4e is a high-level logic flowchart of a process depicting alternate implementations of the data acquisition operation 10-302 of FIG. 10-3.

FIG. 10-4f is a high-level logic flowchart of a process depicting alternate implementations of the data acquisition operation 10-302 of FIG. 10-3.

FIG. 10-4g is a high-level logic flowchart of a process depicting alternate implementations of the data acquisition operation 10-302 of FIG. 10-3.

FIG. 10-4h is a high-level logic flowchart of a process depicting alternate implementations of the data acquisition operation 10-302 of FIG. 10-3.

FIG. 10-4i is a high-level logic flowchart of a process depicting alternate implementations of the data acquisition operation 10-302 of FIG. 10-3.

FIG. 10-4j is a high-level logic flowchart of a process depicting alternate implementations of the data acquisition operation 10-302 of FIG. 10-3.

FIG. 10-4k is a high-level logic flowchart of a process depicting alternate implementations of the data acquisition operation 10-302 of FIG. 10-3.

FIG. 10-4l is a high-level logic flowchart of a process depicting alternate implementations of the data acquisition operation 10-302 of FIG. 10-3.

FIG. 10-4m is a high-level logic flowchart of a process depicting alternate implementations of the data acquisition operation 10-302 of FIG. 10-3.

FIG. 10-5a is a high-level logic flowchart of a process depicting alternate implementations of the hypothesis development operation 10-304 of FIG. 10-3.

FIG. 10-5b is a high-level logic flowchart of a process depicting alternate implementations of the hypothesis development operation 10-304 of FIG. 10-3.

FIG. 10-5c is a high-level logic flowchart of a process depicting alternate implementations of the hypothesis development operation 10-304 of FIG. 10-3.

FIG. 10-6 is a high-level logic flowchart of another process.

FIG. 10-7a is a high-level logic flowchart of a process depicting alternate implementations of the action execution operation 10-606 of FIG. 10-6.

FIG. 10-7b is a high-level logic flowchart of a process depicting alternate implementations of the action execution operation 10-606 of FIG. 10-6.

FIG. 10-7c is a high-level logic flowchart of a process depicting alternate implementations of the action execution operation 10-606 of FIG. 10-6.

FIG. 10-7d is a high-level logic flowchart of a process depicting alternate implementations of the action execution operation 10-606 of FIG. 10-6.

### DETAILED DESCRIPTION

In the following detailed description, reference is made to the accompanying drawings, which form a part hereof. In the drawings, similar symbols typically identify similar components, unless context dictates otherwise. The illustrative embodiments described in the detailed description, drawings, and claims are not meant to be limiting. Other embodiments may be utilized, and other changes may be made, without departing from the spirit or scope of the subject matter presented here.

A recent trend that is becoming increasingly popular in the computing/communication field is to electronically record one's feelings, thoughts, and other aspects of the person's everyday life onto an open diary. One place where such open diaries are maintained are at social networking sites commonly known as “blogs” where users may report or post their latest status, personal activities, and various other aspects of the users' everyday life. The process of reporting or posting blog entries is commonly referred to as blogging. Other social networking sites may allow users to update their personal information via, for example, social networking status reports in which a user may report or post for others to view their current status, activities, and/or other aspects of the user.

A more recent development in social networking is the introduction and explosive growth of microblogs in which individuals or users (referred to as “microbloggers”) maintain open diaries at microblog websites (e.g., otherwise known as “twitters”) by continuously or semi-continuously posting microblog entries. A microblog entry (e.g., “tweet”) is typically a short text message that is usually not more than 140 characters long. The microblog entries posted by a microblogger may report on any aspect of the microblogger's daily life. Typically, such microblog entries will describe the various “events” associated with or are of interest to the microblogger that occurs during a course of a typical day. The microblog entries are often continuously posted during the course of a typical day, and thus, by the end of a normal day, a substantial number of events may have been reported and posted.

Each of the reported events that may be posted through microblog entries may be categorized into one of at least three possible categories. The first category of events that may be reported through microblog entries are “objective occurrences” that may or may not be associated with the microblogger. Objective occurrences that are associated with a microblogger may be any characteristic, incident, happening, or any other event that occurs with respect to the microblogger or are of interest to the microblogger that can be objectively reported by the microblogger, a third party, or by a device. Such events would include, for example, intake of food, medicine, or nutraceutical, certain physical characteristics of the microblogger such as blood sugar level or blood pressure, activities of the microblogger, external events such as performance of the stock market (which the microblogger may have an interest in), performance of a favorite sports team, and so forth.

Other examples of objective occurrences include, for example, external events such as the local weather, activities of others (e.g., spouse or boss), the behavior or activities of a pet or livestock, the characteristics or performances of mechanical or electronic devices such as automobiles, appliances, and computing devices, and other events that may directly or indirectly affect the microblogger.

A second category of events that may be reported or posted through microblog entries include “subjective user states” of the microblogger. Subjective user states of a microblogger may include any subjective state or status associated with the microblogger that can only be typically reported by the microblogger (e.g., generally cannot be directly reported by a third party or by a device). Such states including, for example, the subjective mental state of the microblogger (e.g., happiness, sadness, anger, tension, state of alertness, state of mental fatigue, jealousy, envy, and so forth), the subjective physical state of the microblogger (e.g., upset stomach, state of vision, state of hearing, pain, and so forth), and the subjective overall state of the microblogger (e.g., “good,” “bad,” state of overall wellness, overall fatigue, and so forth). Note that the term “subjective overall state” as will be used herein refers to those subjective states that may not fit neatly into the other two categories of subjective user states described above (e.g., subjective mental states and subjective physical states).

A third category of events that may be reported or posted through microblog entries include “subjective observations” made by the microblogger. A subjective observation is similar to subjective user states and may be any subjective opinion, thought, or evaluation relating to any external incidence (e.g., outward looking instead of inward looking as in the case of subjective user states). Thus, the difference between subjective user states and subjective observations is that subjective user states relates to self-described subjective descriptions of the user states of one's self while subjective observations relates to subjective descriptions or opinions regarding external events. Examples of subjective observations include, for example, a microblogger's perception about the subjective user state of another person (e.g., “he seems tired”), a microblogger's perception about another person's activities (e.g., “he drank too much yesterday”), a microblogger's perception about an external event (e.g., “it was a nice day today”), and so forth. Although microblogs are being used to provide a wealth of personal information, thus far they have been primarily limited to their use as a means for providing commentaries and for maintaining open diaries.

Another potential source for valuable but yet to be fully exploited is data that may be provided by sensing devices that are used to sense and/or monitor various aspects of everyday life. Currently there are a number of sensing devices that can detect and/or monitor various user-related and nonuser-related events. For example, there are presently a number of sensing devices that can sense various physical or physiological characteristics of a person or an animal (e.g., a pet or a livestock). Examples of such devices include commonly known and used monitoring devices such as blood pressure devices, heart rate monitors, blood glucose sensors (e.g., glucometers), respiration sensor devices, temperature sensors, and so forth. Other examples of devices that can monitor physical or physiological characteristics include more exotic and sophisticated devices such as functional magnetic resonance imaging (fMRI) device, functional Near Infrared (fNIR) devices, blood cell-sorting sensing device, and so forth. Many of these devices are becoming more compact and less expensive such that they are becoming increasingly accessible for purchase and/or self-use by the general public.

Other sensing devices may be used in order to sense and/or monitor activities of a person or an animal. These would include, for example, global positioning systems (GPS), pedometers, accelerometers, and so forth. Such devices are compact and can even be incorporated into, for example, a mobile communication device such a cellular telephone or on the collar of a pet. Other sensing devices for monitoring activities of individuals (e.g., users) may be incorporated into larger machines and may be used in order to monitor the usage of the machines by the individuals. These would include, for example, sensors that are incorporated into exercise machines, automobiles, bicycles, and so forth. Today there are even toilet monitoring devices that are available to monitor the toilet usage of individuals.

Other sensing devices are also available that can monitor general environmental conditions such as environmental temperature sensor devices, humidity sensor devices, barometers, wind speed monitors, water monitoring sensors, air pollution sensor devices (e.g., devices that can measure the amount of particulates in the air such as pollen, those that measure CO₂ levels, those that measure ozone levels, and so forth). Other sensing devices may be employed in order to monitor the performance or characteristics of mechanical and/or electronic devices. All the above described sensing devices may provide useful data that may indicate objectively observable events (e.g., objective occurrences).

In accordance with various embodiments, the data provided through social networking sites (e.g., via microblog entries, status entries, diary entries, and so forth) as well as, in some cases, those from sensing devices may be processed in order to develop a hypotheses that identifies the relationship between multiple event types (e.g., types of events). For example, based on past events reported by a person (e.g., a microblogger) and/or reported by sensing devices, a hypothesis such as a hypothesis may be developed relating to the person, a third party, a device, external activities, environmental conditions, or anything else that may be of interest to the person. One way to develop or create such a hypothesis is by identifying a pattern of events that repeatedly reoccurs.

Once such a hypothesis is developed, one or more actions may be executed based on the hypothesis and in response to, for example, occurrence of one or more reported events that may match or substantially match one or more of the event types identified in the hypothesis. Examples of actions that could be executed include, for example, the presentation of advisories or the prompting of one or more devices (e.g., sensing devices or home appliances) to execute one or more operations. However, the development of a hypothesis based on identifying repeatedly reoccurring patterns of events may lead to the development of a faulty or incorrect hypothesis.

As an illustration, suppose a hypothesis is developed by identifying a repetitively reoccurring pattern of events that indicate, for example, that whenever the person wakes-up late, eats ice cream, and drinks coffee, a stomach ache follows. However, merely looking at repetitively reoccurring patterns of events may result in a hypothesis that includes types of events that may not be relevant to the hypothesis or may not accurately reflect the types of events that should be included in the hypothesis. For example, in the above example, waking-up late may not be relevant to having a stomach ache. That is, the hypothesis may have been based on data that indicated that prior to past occurrences of stomachaches, the subject (e.g., user) had reported waking-up late, eating ice cream, and drinking coffee. However, the reports of waking-up late occurring prior to previous reports of stomachaches may merely have been a coincidence. As can be seen, using the technique determining repeatedly reoccurring patterns of events may result in the development of inaccurate or even false hypothesis.

Accordingly, robust methods, systems, and computer program products are provided to, among other things, present to a user a hypothesis identifying at least a relationship between a first event type and a second event type and receive from the user one or more modifications to modify the hypothesis. The methods, systems, and computer program products may then facilitate in the execution of one or more actions based, at least in part, on a modified hypothesis resulting, at least in part, from the reception of the one or more modifications. Examples of the types of actions that may be executed include, for example, the presentation of the modified hypothesis or advisories relating to the modified hypothesis. Other actions that may be executed include the prompting of mechanical and/or electronic devices to execute one or more operations based, at least in part, on the modified hypothesis. In some cases, the execution of the one or more actions, in addition to being based on the modified hypothesis, may be in response to a reported event.

The robust methods, systems, and computer program products may be employed in a variety of environments including, for example, social networking environments, blogging or microblogging environments, instant messaging (IM) environments, or any other type of environment that allows a user to, for example, maintain a diary. Further, the methods, systems, and computing program products in various embodiments may be implemented in a standalone computing device or implemented in a client/server environment.

In various implementations, a “hypothesis,” as referred to herein, may define one or more relationships or links between different types of events (i.e., event types) including defining a relationship between at least a first event type (e.g., a type of event such as a particular type of subjective user state including, for example, a subjective mental state such as “happy”) and a second event type (e.g., another type of event such as a particular type of objective occurrence, for example, favorite sports team winning a game). In some cases, a hypothesis may be represented by an events pattern that may indicate spatial or sequential (e.g., time/temporal) relationships between different event types (e.g., subjective user states, subjective observations, and/or objective occurrences). In some embodiments, a hypothesis may be further defined by an indication of the soundness (e.g., strength) of the hypothesis.

Note that for ease of explanation and illustration, the following description will describe a hypothesis as defining, for example, the sequential or spatial relationships between two, three, or four event types. However, those skilled in the art will recognize that such a hypothesis may also identify the relationships between five or more event types (e.g., a first event type, a second event type, a third event type, a fourth event type, a fifth event type, and so forth).

In some embodiments, a hypothesis may, at least in part, be defined or represented by an events pattern that indicates or suggests a spatial or a sequential (e.g., time/temporal) relationship between different event types. Such a hypothesis, in some cases, may also indicate the strength or weakness of the link between the different event types. That is, the strength or weakness (e.g., soundness) of the correlation between different event types may depend upon, for example, whether the events pattern repeatedly occurs and/or whether a contrasting events pattern has occurred that may contradict the hypothesis and therefore, weaken the hypothesis (e.g., an events pattern that indicates a person becoming tired after jogging for thirty minutes when a hypothesis suggests that a person will be energized after jogging for thirty minutes).

As briefly described above, a hypothesis may be represented by an events pattern that may indicate spatial or sequential (e.g., time or temporal) relationship or relationships between multiple event types. In some implementations, a hypothesis may indicate a temporal relationship or relationships between multiple event types. In alternative implementations a hypothesis may indicate a more specific time relationship or relationships between multiple event types. For example, a sequential pattern may represent the specific pattern of events that occurs along a timeline that may specify the specific amount of time, if there are any, between occurrences of the event types. In still other implementations, a hypothesis may indicate the specific spatial (e.g., geographical) relationship or relationships between multiple event types.

In various embodiments, a hypothesis may initially be provided to a user (e.g., a microblogger or a social networking user) that the hypothesis may or may not be directly associated with. That is, in some embodiments, a hypothesis may be initially provided that directly relates to a user. Such a hypothesis may relate to, for example, one or more subjective user states associated with the user, one or more activities associated with the user, or one or more characteristics associated with the user. In other embodiments, however, a hypothesis may be initially provided that may not be directly associated with a user. For example, a hypothesis may be initially provided that may be particularly associated with a third party (e.g., a spouse of the user, a friend, a pet, and so forth), while in other embodiments, a hypothesis may be initially provided that is directed to a device that may be, for example, operated or used by the user. In still other cases, a hypothesis may be provided that relates to one or more environmental characteristics or conditions.

In some embodiments, the hypothesis to be initially provided to a user may have been originally created based, for example, on reported events as reported by the user through, for example, blog entries, status reports, diary entries, and so forth. Alternatively, such a hypothesis may be supplied by a third party source such as a network service provider or a content provider.

After being presented with the hypothesis, the user may be provided with an opportunity to modify the presented hypothesis. Various types of modifications may be made by the user including, for example, revising or deleting one or more event types identified by the hypothesis, revising one or more relationships between the multiple event types identified by the hypothesis, or adding new event types to the hypothesis. Based on the modifications provided by the user, a modified hypothesis may be generated. In some embodiments, the user may be provided with the option to delete or deactivate the hypothesis or an option to select or revise the type of actions that may be executed based on the modified hypothesis.

Based, at least in part, on the modified hypothesis, one or more actions may be executed. Examples of the types of actions that may be executed include, for example, presenting to the user or a third party one or more advisories related to the modified hypothesis or prompting one or more devices to execute one or more operations based on the modified hypothesis. The one or more advisories that may be presented may include, for example, presentation of the modified hypothesis, presentation of a recommendation for a future action, presentation of a prediction of a future event, and/or presentation of a past event or events. Examples of the types of devices that may be prompted to execute one or more operations include, for example, sensing devices (e.g., sensing devices that can sense physiological or physical characteristics of the user or a third party, sensing devices that can sense the activities of the user or a third party, sensing devices to monitor environmental conditions, and so forth), household appliances, computing or communication devices, environmental devices (e.g., air conditioner, humidifier, air purifier, and so forth), and/or other types of electronic/mechanical devices. In some embodiments, the one or more actions may be in response to, in addition to being based on the modified hypothesis, a reported event.

FIGS. 1a and 1b illustrate an example environment in accordance with various embodiments. In the illustrated environment, an exemplary system 100 may include at least a computing device 10 (see FIG. 1b). In some embodiments, the computing device 10 may be a server (e.g., network server), which may communicate with a user 20a via a mobile device 30 and through a wireless and/or wired network 40. In other embodiments, the computing device 10 may be a standalone device, which may communicate directly with a user 20b via a user interface 122.

Regardless of whether the computing device 10 is a network server or a standalone device, the computing device 10 may be designed to, among other things, present to a user 20* a hypothesis 60 that identifies at least a relationship between a first event type and a second event type, receive from the user 20* one or more modifications 61 to modify the hypothesis 60, and execute one or more actions based, at least in part, on a modified hypothesis 80 resulting, at least in part, from the reception of the one or more modifications 61. As will be further described herein, in embodiments where the computing device 10 is a server that communicates with a user 20a via the mobile device 30, the mobile device 30 may also be designed to perform the above-described operations. In the following, “*” indicates a wildcard. Thus, references to user 20* may indicate a user 20a or a user 20b of FIGS. 1a and 1b. Similarly, references to sensing devices 35* may be a reference to sensing devices 35a or sensing devices 35b of FIGS. 1a and 1b.

As indicated earlier, in some embodiments, the computing device 10 may be a network server (or simply “server”) while in other embodiments the computing device 10 may be a standalone device. In the case where the computing device 10 is a network server, the computing device 10 may communicate indirectly with a user 20a, one or more third parties 50, and one or more sensing devices 35a via wireless and/or wired network 40. A network server, as will be described herein, may be in reference to a server located at a single network site or located across multiple network sites or a conglomeration of servers located at multiple network sites. The wireless and/or wired network 40 may comprise of, for example, a local area network (LAN), a wireless local area network (WLAN), personal area network (PAN), Worldwide Interoperability for Microwave Access (WiMAX), public switched telephone network (PTSN), general packet radio service (GPRS), cellular networks, and/or other types of wireless or wired networks. In contrast, in embodiments where the computing device 10 is a standalone device, the computing device 10 may at least directly communicate with a user 20b (e.g., via a user interface 122) and one or more sensing devices 35b.

The mobile device 30 may be a variety of computing/communication devices including, for example, a cellular phone, a personal digital assistant (PDA), a laptop, a desktop, or other types of computing/communication devices that can communicate with the computing device 10. In some embodiments, the mobile device 30 may be a handheld device such as a cellular telephone, a smartphone, a Mobile Internet Device (MID), an Ultra Mobile Personal Computer (UMPC), a convergent device such as a personal digital assistant (PDA), and so forth.

In embodiments in which the computing device 10 is a standalone device, the computing device 10 may be any type of portable device (e.g., a handheld device) or non-portable device (e.g., desktop computer or workstation). For these embodiments, the computing device 10 may be any one of a variety of computing/communication devices including, for example, a cellular phone, a personal digital assistant (PDA), a laptop, a desktop, or other types of computing/communication devices. In some embodiments, in which the computing device 10 is a handheld device, the computing device 10 may be a cellular telephone, a smartphone, an MID, an UMPC, a convergent device such as a PDA, and so forth. In various embodiments, the computing device 10 may be a peer-to-peer network component device. In some embodiments, the computing device 10 and/or the mobile device 30 may operate via a Web 2.0 construct (e.g., Web 2.0 application 268).

The one or more sensing devices 35* may include one or more of a variety of different types of sensing/monitoring devices to sense various aspects (e.g., characteristics, features, or activities) associated with a user 20*, one or more third parties 50, one or more network and/or local devices 55, one or more external activities, one or more environmental characteristics, and so forth. Examples of such sensing devices 35* include, for example, those devices that can measure physical or physical characteristics of a subject (e.g., a user 20* or a third party 50) such as a heart rate sensor device, blood pressure sensor device, blood glucose sensor device, functional magnetic resonance imaging (fMRI) device, a functional near-infrared (fNIR) device, blood alcohol sensor device, temperature sensor device (e.g., thermometer), respiration sensor device, blood cell-sorting sensor device (e.g., to sort between different types of blood cells), and so forth. Another type of devices that may be included in the one or more sensing devices 35 includes, for example, those that can sense the activities of their subjects (e.g., user 20* or a third party 50). Examples of such devices include, for example, pedometers, accelerometers, an image capturing device (e.g., digital or video camera), toilet monitoring devices, exercise machine sensor devices, and so forth. Other types of sensing devices 35* include, for example, global positioning system (GPS) devices, environmental sensors such as a room thermometer, barometer, air quality sensor device, humidity sensor device, sensing devices to sense characteristics or operational performances of devices, and so forth.

The one or more third parties 50 depicted in FIG. 1a may include, for example, one or more persons (e.g., a spouse, a friend, a social networking group, a co-worker, and so forth), one or more animals (e.g., a pet or livestock), and/or business entities (e.g., content provider, network service provider, etc.).

There are at least two ways that the computing device 10 may initially acquire a hypothesis 60. One way is to acquire the hypothesis 60 from a third party source such as a network service provider, a content provider, or an application provider. A second way is to self-develop the hypothesis 60. For example, in various implementations, and regardless of whether the computing device 10 is a standalone device or as a network server, a hypothesis 60 may be initially developed (e.g., created) by the computing device 10 based, at least in part, on events data that may be provided by one or more sources (e.g., a user 20*, one or more third parties 50, or one or more sensing devices 35*). The events data provided by the one or more sources may indicate past events as reported by the sources. In some cases, such data may be provided by the one or more sources via electronic entries such as blog entries (e.g., microblog entries), status reports, electronic messages (email, instant messages (IMs), etc.), diary entries, and so forth.

By identifying a repeatedly reoccurring pattern of reported events, for example, a hypothesis 60 may be developed by the computing device 10. The resulting hypothesis 60 may indicate a spatial or a sequential (temporal or specific time) relationship between at least a first event type (e.g., a type of subjective user state, a type of subjective observation, or a type of objective occurrence) and a second event type (e.g., a type of subjective user state, a type of subjective observation, or a type of objective occurrence).

The computing device 10 may then present (e.g., indicate via a user interface 122 or transmit via the wireless and/or wired network 40) to a user 20* the hypothesis 60. In embodiments where the computing device 10 is a server, the computing device 10 may present the hypothesis 60 to a user 20a by transmitting the hypothesis 60 to the mobile device 30 via the wireless and/or wired network 40. The mobile device 30 may then audibly and/or visually present the hypothesis 60 to the user 20a. On the other hand, in embodiments where the computing device 10 is a standalone device, the hypothesis 60 may be directly presented to a user 20b by audibly or visually indicating the hypothesis 60 to the user 20a via a user interface 122.

The hypothesis 60 may be presented to a user 20* (e.g., user 20a or user 20b) in a variety of different ways. For example, in various implementations, the hypothesis 60* may be presented in graphical form, in pictorial form, in textual form, in audio form and so forth. In some implementations, the hypothesis 60 to be presented may be modifiable such that one or more event types and/or their relationships (e.g., spatial or temporal/time relationships) with respect to each other that are identified by the hypothesis 60 may be revised or even deleted. Such modifiable hypothesis 60 may also allow a user 20* to add to the hypothesis 60 additional event types with respect to the event types already included in the hypothesis 60. In some implementations, the computing device 10 may present to the user 20* an option to delete or deactivate the hypothesis 60.

After presenting the hypothesis 60 to the user 20*, the computing device 10 may be designed to receive from the user 20* one or more modifications 61 to modify the hypothesis 60. In embodiments in which the computing device 10 is a server, the computing device 10 may receive the one or more modifications 61 from the user 20a through mobile device 30 and via the wireless and/or wired network 40. Note that for these embodiments, the mobile device 30 may directly receive the one or more modifications 61 from the user 20a and may then transmit the one or more modifications 61 to the computing device 10. In alternative embodiments in which the computing device 10 is a standalone device, the computing device 10 may receive the one or more modifications 61 directly from the user 20b via a user interface 122.

In various implementations, the one or more modifications 61 received from the user 20* may be for revising and/or deleting one or more event types and their relationships with respect to each other that are indicated by the hypothesis 60. In some cases, the one or more modifications 61 may also include modifications to add one or more event types with to respect to the event types already included in the hypothesis 60. In other words, the one or more modifications 61 to be received by the computing device 10 and/or by the mobile device 30 may include one or more modifications for adding one or more event types to the hypothesis 60 and their relationships (e.g., spatial or temporal relationships) with the event types already included in the hypothesis 60. Note that in some cases, the computing device 10 (as well as the mobile device 30) may receive from the user 20*, an indication of one or more actions to be executed based, at least in part, on the resulting modified hypothesis 80.

In any event, the computing device 10 may then generate a modified hypothesis 80 by modifying the hypothesis 60 based on the one or more modifications 61 received from the user 20* (user 20a or user 20b). In some embodiments, the modified hypothesis 80 may be stored in memory 140.

The computing device 10 (as well as the mobile device 30) may then execute one or more actions based, at least in part, on the modified hypothesis 80 resulting from the reception of the one or more modifications 61 by the computing device 10. Various types of actions may be executed by the computing device 10 and/or by the mobile device 30 in various alternative embodiments. For example, in some embodiments, the computing device 10 and/or the mobile device 30 may present one or more advisories 90 to a user 20* or to one or more third parties 50. For instance, in embodiments where the computing device 10 is a server, the computing device 10 may present the one or more advisories 90 to a user 20a by transmitting the one or more advisories 90 to the mobile device 30 (or to one or more third parties 50) via a wireless and/or wired network 40. The mobile device 30 may then present the one or more advisories 90 to a user 20a by audibly and/or visually indicating to the user 20a (e.g., via an audio and/or display system) the one or more advisories 90.

In embodiments in which the computing device 10 is a standalone device, the computing device 10 may present the one or more advisories 90 to a user 20b by audibly and/or visually indicating to the user 20b (e.g., via an audio and/or display system) the one or more advisories. For these embodiments, the computing device 10 may present the one or more advisories 90 to one or more third parties 50 by transmitting the one or more advisories 90 to the one or more third parties 50 via a wireless and/or wired network 40.

The one or more advisories 90 to be presented by the computing device 10 or by the mobile device 30 may be one or more of a variety of advisories that may be associated with the modified hypothesis 80 and that can be presented. For example, in some implementations, the one or more advisories 90 to be presented may include at least one form (e.g., an audio form, a graphical form, a pictorial form, a textual form, and so forth) of the modified hypothesis 80. In the same or different implementations, the one or more advisories 90 to be presented may include a prediction of a future event or an indication of an occurrence of a past reported event. In the same or different implementations, the one or more advisories 90 to be presented may include a recommendation for a future course of action and in some cases, justification for the recommendation.

In some embodiments, the computing device 10 and/or the mobile device 30 may execute one or more actions by prompting 91* one or more devices (e.g., one or more sensing devices 35* and/or one or more network/local devices 55) to execute one or more operations. For example, prompting 91* one or more sensing devices 35* to sense various characteristics associated with a user 20* or a third party 50, or prompting one or more household devices (which may be network and/or local devices 55) to perform one or more operations. Note that references to “prompting one or more to execute one or more devices” herein may be in reference to directing, instructing, activating, requesting, and so forth, one or more devices to execute one or more operations.

In embodiments in which the computing device 10 is a server, the computing device 10 may indirectly or directly prompt one or more devices. For example, in some embodiments, the computing device 10 may indirectly prompt one or more devices to execute one or more operations by transmitting to the mobile device 30 a request or instructions to prompt other devices to execute one or more operations. In response to the request or instructions transmitted by the computing device 10, the mobile device 30 may directly prompt 91′ one or more devices (e.g., sensing devices 35* and/or network and/or local devices 55) to execute one or more operations. In the same or different embodiments, the computing device 10 may alternatively or complimentarily directly prompt 91 the one or more devices (e.g., sensing devices 35 and/or network and/or local devices 55) to execute one or more operations. In embodiments in which the computing device 10 is a standalone device, the computing device 10 may directly (e.g., without going through mobile device 30) prompt 91 the one or more devices (e.g., sensing devices 35* and/or network and/or local devices 55) to execute the one or more operations.

In some embodiments, the one or more actions to be executed by the computing device 10 or by the mobile device 30 may be in response, at least in part, to a reported event. For instance, the one or more actions to be executed by the computing device 10 or by the mobile device 30 may be in response to a reported event 62 that at least substantially matches with at least one of the event types identified by the modified hypothesis 80. To illustrate, suppose the modified hypothesis 80 indicates that the gas tank of car belonging to a user 20* is always empty (e.g., a first event type) whenever a particular friend returns a car after borrowing it (e.g., a second event type). In response to receiving data (e.g., in the form of a blog entry or status report) that indicates that the particular friend has again borrowed and returned the user's car (e.g., reported event 62), and based at least in part on the modified hypothesis 80, the computing device 10 may execute one or more actions (e.g., transmitting one or more advisories such as a warning to fill-up the gas tank to the mobile device 30). In this example, the computing device 10 may execute the one or more actions because the reported event 62 at least substantially matches the second event type as identified by the modified hypothesis 80. Note that the reported event 62 that may initiate the one or more actions to be executed by the computing device 10 or the mobile device 30 (which in the above example, may execute one or more actions by audibly or visually indicating the one or more advisories 90) may be reported by a user 20*, one or more third parties 50, or from one or more sensing devices 35*.

Referring particularly now to the computing device 10 of FIG. 1b, which may include one or more components and/or modules. As those skilled in the art will recognize, these components and modules may be implemented by employing hardware (e.g., in the form of circuitry such as application specific integrated circuit or ASIC, field programmable gate array or FPGA, or other types of circuitry), software, a combination of both hardware and software, or may be implemented by a general purpose computing device executing instructions included in a signal-bearing medium.

In various embodiments, the computing device 10 may include a hypothesis presentation module 102, a modification reception module 104, a hypothesis modification module 106, an action execution module 108, a reported event reception module 110, a hypothesis development module 112, a network interface 120 (e.g., network interface card or NIC), a user interface 122 (e.g., a display monitor, a touchscreen, a keypad or keyboard, a mouse, an audio system including a microphone and/or speakers, an image capturing system including digital and/or video camera, and/or other types of interface devices), a memory 140, and/or one or more applications 126. In some implementations, a copy of the hypothesis 60 and/or a copy of a modified hypothesis 80 may be stored in memory 140. The one or more applications 126 may include one or more communication applications 267 (e.g., email application, IM application, text messaging application, a voice recognition application, and so forth) and/or one or more Web 2.0 applications 268. Note that in various embodiments, a persistent copy of the one or more applications 126 may be stored in memory 140.

Turning now to FIG. 2a illustrating particular implementations of the hypothesis presentation module 102 of FIG. 1b. The hypothesis presentation module 102 may be configured to present one or more hypotheses 60 including presenting to a user 20* a hypothesis 60 identifying at least a relationship between at least a first event type (e.g., a subjective user state, a subjective observation, or an objective occurrence) and a second event type (e.g., a subjective user state, a subjective observation, or an objective occurrence). Note that in embodiments in which the computing device 10 is a server, the hypothesis 60 to be presented may be presented to user 20a by transmitting the hypothesis 60 to a mobile device 30, which may then audibly or visually indicate the hypothesis 60 to user 20a. While in embodiments in which the computing device 10 is a standalone device, the computing device 10 may present the hypothesis 60 to a user 20b via the user interface 122.

In some implementations, the hypothesis 60 to be presented may identify the relationships between the first, the second event type, a third event type, a fourth event type, and so forth. As will be further described herein, the hypothesis 60 to be presented by the hypothesis presentation module 102 may identify the relationship between a variety of different event types (e.g., identifying a relationship between a subjective user state and an objective occurrence, identifying a relationship between a first objective occurrence and a second objective occurrence, and so forth). In some implementations, the hypothesis 60 to be presented may have been previously developed based on data provided by the user 20*. In the same or different implementations, the hypothesis 60 to be presented may be related to the user 20*, to one or more third parties 50, to one or more devices, or to one or more environmental characteristics or conditions.

In order to present a hypothesis 60, the hypothesis presentation module 102 may further include one or more sub-modules. For instance, in various implementations, the hypothesis presentation module 102 may include a network transmission module 202 configured to transmit the hypothesis 60 to a user 20a via at least one of a wireless network and a wired network (e.g., wireless and/or wired network 40).

In the same or different implementations, the hypothesis presentation module 102 may include a user interface indication module 204 configured to indicate the hypothesis 60 to a user 20b via a user interface 122 (e.g., an audio system including one or more speakers and/or a display system including a display monitor or touchscreen). The user interface indication module 204 may, in turn, further include one or more additional sub-modules. For example, in some implementations, the user interface indication module 204 may include an audio indication module 206 configured to audibly indicate the hypothesis 60 to user 20b.

In the same or different implementations, the user interface indication module 204 may include a visual indication module 208 configured to visually indicate the hypothesis 60 to user 20b. Note that, and as will be further described herein, the visual indication module 208 may visually indicate the hypothesis 60 in a variety of different manners including, for example, in graphical form, in textual form, in pictorial form, and so forth. Further, in various implementations, the visual indication module 208 may represent the various event types and their relationships with respect to each other as indicated by the hypothesis 60 by symbolic representations (see, for example, FIGS. 2h to 2k).

For example, the visual indication module 208 indicating visually to the user 20* symbolic representations that may represent the various event types indicated by the hypothesis 60 including, for example, a first symbolic representation representing the first event type, a second symbolic representation representing the second event type, a third symbolic representation representing a third event type, a fourth symbolic representation representing a fourth event type, and so forth. A symbolic representation may be, for example, an icon, an emoticon, a figure, text such as a word or phrase, and so forth. Similarly, the visual indication module 208 may indicate the relationships (e.g., spatial or temporal relationships) between the event types, as identified by the hypothesis 60, by visually indicating symbolic representations that represents the relationships between the event types. Such symbolic representations representing the relationships between the event types may include, for example, specific spacing or angle between the symbolic representations representing the event types (e.g., as set against a grid background), lines or arrows between the symbolic representations representing the event types, text including a word or phrase, and/or a combination thereof.

In some implementations, the visual indication module 208 may further include a visual attribute adjustment module 210 that is configured to indicate the strength of the hypothesis 60 by adjusting a visual attribute (e.g., boldness, color, background, and so forth) associated with at least one of the symbolic representations representing the event types and their relationships. In various implementations, the hypothesis presentation module 102 may include an editable hypothesis presentation module 212 configured to present an editable form of the hypothesis 60 to the user 20*. In some embodiments, the editable form of the hypothesis 60 to be presented by the editable hypothesis presentation module 212 may include symbolic representations representing the event types and their relationships with respect to each other that may be modified and/or deleted. In the same or different implementations, the editable form of the hypothesis 60 may be modified such that additional event types may be added with respect to the event types already identified by the hypothesis 60.

In some implementations, the hypothesis presentation module 102 of FIG. 2a may include a hypothesis deletion option presentation module 214 configured to present an option to delete the hypothesis 60. In the same or alternative implementations, the hypothesis presentation module 102 may include a hypothesis deactivation option presentation module 216 configured to present an operation to deactivate or ignore the hypothesis 60. By deactivating the hypothesis 60, the action execution module 108 of the computing device 10 may be prevented from executing one or more actions based on the hypothesis 60 (e.g., or a modified version of the hypothesis 60).

Turning now to FIG. 2b illustrating particular implementations of the modification reception module 104 of FIG. 1b. In various implementations, the modification reception module 104 may be configured to receive at least one modification 61 to modify the hypothesis 60 from the user 20*. The modification reception module 104 may include one or more sub-modules in various alternative implementations. For example, in some implementations such as in implementations in which the computing device 10 is a standalone device, the modification reception module 104 may include a user interface reception module 218 configured to receive the at least one modification 61 for modifying the hypothesis 60 through a user interface 122 (e.g., a key pad, a microphone, a touchscreen, a mouse, a keyboard, and so forth). In the same or different implementations such as in implementations in which the computing device 10 is a server, the modification reception module 104 may include a network reception module 220 configured to receive the at least one modification 61 for modifying the hypothesis 60 via at least one of a wireless and/or wired network 40.

As depicted in FIG. 2b, the modification reception module 104 may include, in various implementations, an electronic entry reception module 222 configured to receive (e.g., via a user interface 122 or via wireless and/or wired network 40) the at least one modification 61 to modify the hypothesis 60 via one or more electronic entries as provided by the user 20*. In some implementations, the electronic entry reception module 222 may further include one or more sub-modules including, for example, a blog entry reception module 224 (e.g., for receiving from the user 20* the at least one modification 61 via one or more blog or microblog entries), a status report reception module 226 (e.g., for receiving from the user 20* the at least one modification 61 via one or more social networking status reports), an electronic message reception module 228 (e.g., for receiving from the user 20* the at least one modification 61 via one or more electronic messages such as e.g., emails, text messages, instant messages (IMs), and so forth), and/or a diary entry reception module 230 (e.g., for receiving from the user 20* the at least one modification 61 via one or more diary entries).

Various types of modifications 61 for modifying the hypothesis 60 may be received by the modification reception module 104. For instance, in some implementations, modifications 61 for deleting one or more of the event types (e.g., the first event type, the second event type, and so forth) indicated by the hypothesis 60 may be received by the modification reception module 104. For example, the modification reception module 104 may receive one or more modifications 61 for deleting a third event type, a fourth event type, and so forth, indicated by the hypothesis 60.

In some implementations, the modification reception module 104 may be designed to receive one or more modifications 61 for adding additional event types (e.g., a third event type, a fourth event type, and so forth) to the hypothesis 60 and with respect to the at least first event type and the second event type already included in the hypothesis 60. Note that when adding a new event type to the hypothesis 60, the relationships (e.g., spatial or temporal) between the added event type (e.g., a third event type) and the first event type and the second event type may also be provided.

In some implementations, the modification reception module 104 may be designed to receive one or more modifications 61 for revising one or more of the event types (e.g., the first event type and the second event type) included in the hypothesis 60. In the same or different implementations, the modification reception module 104 may be configured to receive one or more modifications 61 for modifying (e.g., revising) the relationship or relationships (e.g., spatial, temporal, or specific time relationship) between the event types (e.g., the first event type, the second event type, and so forth) included in the hypothesis 60. The one or more modifications 61 to be received by the modification reception module 104 may be for modifying any type of event types including, for example, a subjective user state type, a subjective observation type, and/or an objective occurrence type.

In various implementations, the computing device 10 may include a hypothesis modification module 106 that is designed to modify the hypothesis 60 based, for example, on the one or more modifications 61 received by the modification reception module 104. As a result of modifying the hypothesis 60, a modified hypothesis 80 may be generated, which in some cases may be stored in memory 140.

FIG. 2c illustrates particular implementations of the action execution module 108 of FIG. 1b. The action execution module 108 may be designed to execute at least one action based, at least in part, on a modified hypothesis 80 generated as a result, at least in part, of the reception of the at least one modification 61 by the modification reception module 104. As depicted in FIG. 2c, the action execution module 108 may include an advisory presentation module 232 that may be configured to present (e.g., indicate via user interface 122 or transmit via wireless and/or wired network 40) at least one advisory 90 related to the modified hypothesis 80. In various implementations, the at least one advisory 90 may be presented to a user 20* and/or one or more third parties 50.

The advisory presentation module 232 may further include one or more sub-modules in various alternative implementations. For instance, in various implementations, the advisory presentation module 232 may include a user interface indication module 234 that is configured to indicate the at least one advisory 90 via a user interface 122. In the same or different implementations, the advisory presentation module 232 may include a network transmission module 236 configured to transmit the at least one advisory 90 via a wireless and/or wired network 40. The network transmission module 236 may transmit the at least one advisory 90 to, for example, a user 20a (e.g., via mobile device 30) and/or one or more third parties 50.

In the same or different implementations, the advisory presentation module 232 may include a modified hypothesis presentation module 238 configured to present one or more form of the modified hypothesis 80. For instance, presenting an audio form, a textual form, a pictorial form, a graphical form, and/or other forms of the modified hypothesis 80. The modified hypothesis presentation module 238 may present the at least one form of the modified hypothesis 80 by presenting an indication of a spatial, temporal, or specific time relationship between at least two event types indicated by the modified hypothesis 80. The at least one form of the modified hypothesis 80 presented by the modified hypothesis presentation module 238 may indicate the relationship between the event types indicated by the modified hypothesis 80 including any combination of subjective user state types, objective occurrence types, and/or subjective observation types (e.g., indicate a relationship between a first type of subjective user state and a second type of subjective user state, indicate a relationship between a type of subjective user state and a type of objective occurrence, indicate a relationship between a type of subjective user state and a type of subjective observation, and so forth) as indicated by the modified hypothesis 80.

The advisory presentation module 232 may further include other sub-modules in various implementations. For example, in some implementations, the advisory presentation module 232 may include a prediction presentation module 240 configured to present at least one advisory 90 relating to a predication of one or more future events based, at least in part, on the modified hypothesis 80. For example, predicting that “a personal passenger vehicle belonging to the user will breakdown sometime during the coming week.”

In various implementations, the advisory presentation module 232 may include a recommendation presentation module 242 configured to present at least one advisory 90 recommending a future course of action based, at least in part, on the modified hypothesis 80. For example, recommending that “the user take his personal passenger vehicle into the shop for repairs.” In some implementations, the recommendation presentation module 242 may include a justification presentation module 244 configured to present a justification for the recommendation presented by the recommendation presentation module 242. For example, indicating that “the user should take her personal passenger vehicle into the shop because the last time the user did not take her personal vehicle into the shop after driving it for 15 thousand miles without being serviced, the personal vehicle broke down.”

In some implementations, the advisory presentation module 232 may include a past event presentation module 246 configured to present an indication of one or more past events based, at least in part, on the modified hypothesis 80 (e.g., “the last time your husband went drinking, he overslept”).

In various implementations, the action execution module 108 may include a device prompting module 248 configured to prompt (e.g., as indicated by ref 91) at least one devices to execute at least one operation based, at least in part, on the modified hypothesis 80. The at least one device to be prompted to execute the at least one operation may include, for example, one or more sensing devices 35*, or one or more network/local devices 55. Network/local devices 55 are any device that may interface with a wireless and/or wired network 40 and/or any device that may be local with respect to, for example, the computing device 10. Examples of network/local devices 55 includes, for example, household devices such as household appliances, automobiles (or portions thereof), environmental devices such as air conditioners, humidifier, air purifiers, and so forth, electronic/communication devices (e.g., mobile device 30), and so forth.

In various alternative implementations, the device prompting module 248 may include one or more sub-modules. For example, in some implementations, the device prompting module 248 may include a device instruction module 250 configured to directly or indirectly instruct the at least one device (e.g., directly instructing a local device or indirectly instructing a network device via wireless and/or wired network 40) to execute the at least one operation. In the same or different implementations, the device prompting module 248 may include a device activation module 252 configured to directly or indirectly activate the at least one device (e.g., directly activating a local device or indirectly activating a network device via wireless and/or wired network 40) to execute the at least one operation. In the same or different implementations, the device prompting module 248 may include a device configuration module 254 designed to directly or indirectly configure the at least one device (e.g., directly configuring a local device or indirectly configuring a network device via wireless and/or wired network 40) to execute the at least one operation.

Referring back to the action execution module 108 of FIGS. 1b and 2c, in various implementations, the action execution module 108 may be configured to execute the one or more actions based on the modified hypothesis 80 as generated by the hypothesis modification module 106 and in response to a reported event. For example, the one or more actions may be executed if the reported event at least substantially matches with at least one of the event types (e.g., substantially matches with at least one of at least two event types) identified by the modified hypothesis 80. In some specific implementations, the one or more actions may only be executed if the reported event matches at least one of the event types identified by the modified hypothesis 80.

In various implementations, the computing device 10 of FIG. 1b may include one or more applications 126. The one or more applications 126 may include, for example, one or more communication applications 267 (e.g., text messaging application, instant messaging application, email application, voice recognition system, and so forth) and/or Web 2.0 application 268 to facilitate in communicating via, for example, the World Wide Web. In some implementations, copies of the one or more applications 126 may be stored in memory 140.

In various implementations, the computing device 10 may include a network interface 120, which may be a device designed to interface with a wireless and/or wired network 40. Examples of such devices include, for example, a network interface card (NIC) or other interface devices or systems for communicating through at least one of a wireless network or wired network 40. In some implementations, the computing device 10 may include a user interface 122. The user interface 122 may comprise any device that may interface with a user 20b. Examples of such devices include, for example, a keyboard, a display monitor, a touchscreen, a microphone, a speaker, an image capturing device such as a digital or video camera, a mouse, and so forth.

The computing device 10 may include a memory 140. The memory 140 may include any type of volatile and/or non-volatile devices used to store data. In various implementations, the memory 140 may comprise, for example, a mass storage device, a read only memory (ROM), a programmable read only memory (PROM), an erasable programmable read-only memory (EPROM), random access memory (RAM), a flash memory, a synchronous random access memory (SRAM), a dynamic random access memory (DRAM), and/or other memory devices. In various implementations, the memory 140 may store an existing hypotheses 80 and/or historical data (e.g., historical data including, for example, past events data or historical events patterns related to a user 20*, related to a subgroup of the general population that the user 20* belongs to, or related to the general population).

FIG. 2d illustrates particular implementations of the mobile device 30 of FIG. 1a. The mobile device 30, as previously described, may be a larger computing/communication device such as a laptop or a desktop computer, or a smaller computing/communication device including a handheld device such as a cellular telephone, a smart phone, a PDA, and so forth. In various embodiments, the mobile device 30 may include components and modules similar to those included in the computing device 10 of FIG. 1b.

For example, and similar to the computing device 10, the mobile device 30 may also include a hypothesis presentation module 102′, a modification reception module 104′, an action execution module 108′, a reported event reception module 110′, a network interface 120′, a user interface 122′, a memory 140′, and/or one or more applications 126′, which may include one or more communication applications 267′ and/or one or more Web 2.0 applications 268′. Note that in some implementations, memory 140′ may store a copy of the hypothesis 60 and/or the modified hypothesis 80′. These components and modules may generally perform the same or similar functions as their counterparts in the computing device 10 the computing device 10 with certain exceptions. For instance, with respect to the hypothesis presentation modules 102* of the mobile device 30 and the computing device 10, in the mobile device 30 case the hypothesis presentation module 102′ may present (e.g., audibly or visually indicate) a hypothesis 60 to a user 20a via a user interface 122′ while in the computing device 10 the hypothesis presentation module 102 may present a hypothesis 60 to a user 20a by transmitting the hypothesis 60 to the mobile device 30 via wireless and/or wired network 40 (e.g., in embodiments in which the computing device 10 is a server) or may present (e.g., audibly or visually indicate) the hypothesis 60 to a user 20b via a user interface 122 (e.g., in embodiments in which the computing device 10 is a standalone device). Note also that the unlike the computing device 10, the mobile device 30 may not include a hypothesis modification module 106 or a hypothesis development module 112 since operations performed by such modules may be performed by, for example, a server (e.g., computing device 10 in embodiments in which the computing device 10 is a server).

In addition to those components and modules described above, the mobile device 30 may include a modification transmission module 219 and an advisory reception module 235. The modification transmission module 219 may be designed to, among other things, transmit one or more modifications 61 (e.g., as provided by a user 20a through user interface 122′) to a server (e.g., computing device 10 in embodiments in which the computing device 10 is a server) via, for example, wireless and/or wired network 40. The advisory reception module 235 may be designed to receive one or more advisories 90 related to the modified hypothesis 80 from the computing device 10 via, for example, wireless and/or wired network 40, the modified hypothesis 80 being generated by the computing device 10 (e.g., in embodiments in which the computing device 10 is a server) based on the hypothesis 60 and the one or more modifications 61 received from the mobile device 30.

FIG. 2e illustrates particular implementations of the hypothesis presentation module 102′ of the mobile device 30 of FIG. 2d. The hypothesis presentation module 102′ of the mobile device 30 may perform the same or similar functions (e.g., present one or more hypotheses including presenting to a user 20a a hypothesis 60) as the hypothesis presentation module 102 of the computing device 10 (e.g., in embodiments in which the computing device 10 is a standalone device). As illustrated, the hypothesis presentation module 102′ may include a user interface indication module 204′, an editable hypothesis presentation module 212′, a hypothesis deletion option presentation module 214′, and/or a hypothesis deactivation option presentation module 216′. In various implementations, the user interface indication module 204′ may further include an audio indication module 206′ and a visual indication module 208′, which may further include a visual attribute adjustment module 210′. These modules corresponds to and may perform the same or similar functions as the user interface indication module 204 (which may include the audio indication module 206, the visual indication module 208, and the visual attribute adjustment module 210), the editable hypothesis presentation module 212, the hypothesis deletion option presentation module 214, and the hypothesis deactivation option presentation module 216 (see FIG. 2a), respectively, of computing device 10.

FIG. 2f illustrates particular implementations of the modification reception module 104′ of the mobile device 30 of FIG. 2d. In various implementations, the modification reception module 104′ may perform the same or similar functions (e.g., to receive at least one modification 61 to modify the hypothesis 60 from the user 20a) as the modification reception module 104 of the computing device 10 (e.g., in embodiments in which the computing device 10 is a standalone device). As illustrated, the modification reception module 104′ may include a user interface reception module 218′ and an electronic entry reception module 222′, which may further include a blog entry reception module 224′, a status report reception module 226′, electronic message reception module 228′, and/or diary entry reception module 230′. These modules may correspond to and may perform the same or similar functions as the functions performed by the user interface reception module 218, the electronic entry reception module 222, the blog entry reception module 224, the status report reception module 226, the electronic message reception module 228, and the diary entry reception module 230 (see FIG. 2b), respectively, of the computing device 10.

FIG. 2g illustrates particular implementations of the action execution module 108′ of the mobile device 30 of FIG. 2d. In various implementations, the action execution module 108′ may perform the same or similar functions (e.g., executing one or more actions based, at least in part, on a modified hypothesis 80 resulting, at least in part, from the reception of the one or modifications 61 by the modification reception module 104′) as the action execution module 108 of the computing device 10 (e.g., in embodiments in which the computing device 10 is a standalone device). As illustrated, the action execution module 108′ may include an advisory presentation module 232′ and a device prompting module 248′ that corresponds to and performs the same or similar functions as the advisory presentation module 232 and the device prompting module 248 of the computing device 10. As further illustrated, the advisory presentation module 232′ may further include the same one or more sub-modules (e.g., a user interface indication module 234′, a network transmission module 236′, a modified hypothesis presentation module 238′, a prediction presentation module 240′, a recommendation presentation module 242′ that further includes a justification presentation module 244′, and/or a justification presentation module 244′) that may be included in the advisory presentation module 232 of the computing device 10 performing the same or similar functions as their counterparts in the computing device 10. Likewise, the device prompting module 248′ may further include the same one or more sub-modules (e.g., a device instruction module 250′, a device activation module 252′, and/or a device configuration module 254′) that may be included in the device prompting module 248 of the computing device 10 performing the same or similar functions as their counterparts in the computing device 10.

There are many ways that a hypothesis 60 (or a modified hypothesis 80) may be visually or audibly indicated to a user 20*. FIGS. 2h to 2k illustrates just a few examples of how a hypothesis 60 (or a modified hypothesis 80) may be visually indicated on a user interface display device such as a display monitor or touchscreen. In particular, FIG. 2h is an exemplary textual version of a hypothesis 60 being visually indicated on a user interface display 270. The user interface display 270 shows a textual message indicating the hypothesis 60. In this case, some groups of words within the message represent different event types, while other words in the message represent the temporal relationships between the event types. For example, refs. 271, 272, 273, and 274 indicate selective words in the textual message that are different symbolic representations of different event types (e.g., waking up late, eating ice cream, drinking coffee, and stomachache). Refs. 275a, 275b, and 275c indicate symbolic representations (e.g., in the form of words) that represents the relationships (e.g., sequential or temporal relationships) between the different event types represented on the user interface display 270.

FIG. 2i is an exemplary pictorial version of the hypothesis 60 textually illustrated in FIG. 2h being pictorially indicated on a user interface display 276. The user interface display 276 shows multiple symbolic representations (refs. 277, 278, 279, 280, 281a, 281b, and 281c) in the form of emoticons and figures/icons that represents the different event types and their relationships with each other. For instance, in this example the symbolic representation 277 (in the form of an emoticon) represents the event type “waking up late.” The symbolic representation 278 (in the form of a figure/icon) represents the event type “eating ice cream.” The symbolic representation 279 (in the form of a figure/icon) represents the event type “drinking coffee.” The symbolic representation 280 (in the form of an emoticon) represents the event type “stomachache.” The symbolic representations 281a, 281b, and 281c (in the form of arrows) represents the temporal relationships between the event types (e.g., as represented by symbolic representations 277, 278, 279, and 280) represented on the user interface display 276.

FIG. 2j is another exemplary pictorial version of the hypothesis 60 that was textually illustrated in FIG. 2h being again pictorially indicated on a user interface display 284. The user interface display 284 shows oval shapes (symbolic representations 285, 286, 287, and 288) that represents the four different event types. The relationships (e.g., temporal relationships) between the four different event types (as represented by the symbolic representations 285, 286, 287, and 288) may be symbolically represented by the specific placement of the symbolic representations 285, 286, 287, and 288 with respect to the user interface display 284 and with respect to each other. For example, in this illustrated example the top left corner of the user interface display may represent the earliest point in time, while the bottom right corner may represent the latest point in time. Thus, symbolic representation 285 (e.g., representing “wake up late”) being closest to the top left corner of the user interface display 284 represents the earliest event type to occur, while symbolic representation 288 (e.g., representing “stomach ache”), which is located nearest to the bottom right corner, represents the latest event type to occur. Note that symbolic representation 286 and symbolic representation 287 intersect each other. Thus, the event types (e.g., “eat ice cream” and “drink coffee”) that they represent are at least partially concurrently occurring event types. In order to facilitate a user in understanding the time relationships between the different event types a time increment grid may be placed in the background.

FIG. 2k illustrates a pictorial/graphical representation of a hypothesis 60 (e.g., a hypothesis 60 that links going to work, arriving at work, drinking coffee, learning boss plans to leave town, boss leaving town, and overall user state) being pictorially/graphically represented on a user interface display 290. In this example, most of the event types indicated by the hypothesis 60 are represented by blocks (e.g., symbolic representations 291a, 291b, 291c, 291d, and 291e) below a timeline. The overall user state is represented symbolically by a line to indicate the specific overall user state at any given moment in time. Note that by employing the robust systems and methods described herein, a user may be able to modify the hypothesis 60 depicted in the user interface display 290. That is, the user may choose to modify the hypothesis 60 by deleting symbolic representations 291a, 291b, and 291c (e.g., representing going to work, arriving at work, and drinking coffee) if the user feels that the events represented by the symbolic representations may not be relevant to the user having a very good overall user state.

The various features and characteristics of the components, modules, and sub-modules of the computing device 10 and mobile device 30 presented thus far will be described in greater detail with respect to the processes and operations to be described herein.

FIG. 3 illustrates an operational flow 300 representing example operations related to, among other things, presenting a hypothesis to a user that identifies at least a relationship between a first event type and a second event type, receiving one or more modifications to modify the hypothesis from the user, and executing one or more actions based, at least in part, on a modified hypothesis resulting at least in part from the reception of the one or more modifications. In some embodiments, the operational flow 300 may be executed by, for example, the mobile device 30 or the computing device 10 of FIGS. 1a and 1b.

In FIG. 3 and in the following figures that include various examples of operational flows, discussions and explanations may be provided with respect to the above-described exemplary environment of FIGS. 1a and 1b, and/or with respect to other examples (e.g., as provided in FIGS. 2a-2k) and contexts. However, it should be understood that the operational flows may be executed in a number of other environments and contexts, and/or in modified versions of FIGS. 1a, 1b, and 2a-2k. Also, although the various operational flows are presented in the sequence(s) illustrated, it should be understood that the various operations may be performed in different sequential orders other than those which are illustrated, or may be performed concurrently.

Further, in the following figures that depict various flow processes, various operations may be depicted in a box-within-a-box manner. Such depictions may indicate that an operation in an internal box may comprise an optional example embodiment of the operational step illustrated in one or more external boxes. However, it should be understood that internal box operations may be viewed as independent operations separate from any associated external boxes and may be performed in any sequence with respect to all other illustrated operations, or may be performed concurrently.

In any event, after a start operation, the operational flow 300 may move to a hypothesis presentation operation 302 for presenting to a user a hypothesis identifying at least a relationship between a first event type and a second event type. For instance, the hypothesis presentation module 102* of the mobile device 30 or the computing device 10 presenting (e.g., indicating via a user interface 122* or transmitting via wireless and/or wired network 40) to a user 20* a hypothesis 60 identifying at least a relationship between a first event type (e.g., a subjective user state, a subjective observation, or an objective occurrence) and a second event type (e.g., a subjective user state, a subjective observation, or an objective occurrence).

Next, operational flow 300 may include a modification reception operation 304 for receiving from the user one or more modifications to modify the hypothesis. For instance, the modification reception module 104* of the mobile device 30 or the computing device 10 receiving (e.g., receiving via a user interface 122 or via wireless and/or wired network 40) from the user 20* one or more modifications 61 to modify the hypothesis 60.

Finally, operation flow 300 may include an action execution operation 306 for executing one or more actions based, at least in part, on a modified hypothesis resulting, at least in part, from the reception of the one or more modifications. For instance, the action execution module 108* of the mobile device 30 or the computing device 10 executing one or more actions (e.g., presenting one or more advisories 90 or configuring a device to execute one or more operations) based, at least in part, on a modified hypothesis 80 resulting, at least in part, from the reception of the one or more modifications 61. In a more specific example, the action execution module 108′ of the mobile device 30 executing one or more actions (e.g., displaying the modified hypothesis 80 or prompting 91′ one or more devices such as one or more sensing devices 35* or network/local devices 55 to execute one or more operations) after receiving from the computing device 10 (e.g., when the computing device 10 is a server) a request for executing the one or more actions. In this example, the request may have been generated and transmitted by the computing device 10 based, at least in part, on the modified hypothesis 80.

Referring back to the hypothesis presentation operation 302, the hypothesis 60 presented through the hypothesis presentation operation 302 may be presented in a variety of different ways. For example, in some implementations, the hypothesis presentation operation 302 may include an operation 402 for transmitting to the user, via at least one of a wireless network and a wired network, the hypothesis as depicted in FIG. 4a. For instance, the network transmission module 202 (see FIG. 2a) of the computing device 10 (e.g., in embodiments in which the computing device 10 is a server) transmitting to the user 20a, via at least one of a wireless network and a wired network 40, the hypothesis 60.

In some alternative implementations, the hypothesis presentation operation 302 may include an operation 403 for indicating to the user, via a user interface, the hypothesis as depicted in FIG. 4a. For instance, the user interface indication module 204* of the mobile device 30 or the computing device 10 (e.g., in embodiments in which the computing device 10 is a standalone device) indicating to the user 20*, via a user interface 122*, the hypothesis 60.

In some implementations, operation 403 may include an operation 404 for indicating audibly to the user the hypothesis as depicted in FIG. 4a. For instance, the audio indication module 206* of the mobile device 30 or the computing device 10 (e.g., in embodiments in which the computing device 10 is a standalone device) indicating audibly (e.g., via speaker system) to the user 20* the hypothesis 60.

In the same or different implementations, operation 403 may include an operation 405 for indicating visually to the user the hypothesis as depicted in FIG. 4a. For instance, the visual indication module 208* of the mobile device 30 or the computing device 10 (e.g., in embodiments in which the computing device 10 is a standalone device) indicating visually (e.g., via a display device such as a display monitor or touchscreen) to the user 20* the hypothesis 60.

In some implementations, operation 405 may further include an operation 406 for indicating visually to the user the hypothesis via a display screen as depicted in FIG. 4a. For instance, the visual indication module 208* of the mobile device 30 or the computing device 10 indicating visually to the user 20* the hypothesis 60 via a display screen (e.g., touchscreen).

The hypothesis 60 to be visually indicated through operation 405 may be indicated in a variety of ways including, for example, in text form, in graphical form, in pictorial form, and so forth. For example, in various implementations, operation 405 may include an operation 407 for indicating visually to the user a first symbolic representation representing the first event type and a second symbolic representation representing the second event type as depicted in FIG. 4a. For instance, the visual indication module 208* of the mobile device 30 or the computing device 10 indicating visually to the user 20* a first symbolic representation representing the first event type and a second symbolic representation representing the second event type. A symbolic representation may be, for example, an icon, an emoticon, a figure, text, a number, and so forth.

In some implementations, operation 407 may further include an operation 408 for indicating visually to the user a third symbolic representation representing the relationship between the first event type and the second event type as depicted in FIG. 4a. For instance, the visual indication module 208* of the mobile device 30 or the computing device 10 indicating visually to the user 20* a third symbolic representation representing the relationship between the first event type and the second event type. For example, in some implementations, the third symbolic representation may be the spacing between the first and second symbolic representations shown on a display screen, a line or an arrow between the first and second symbolic representations, an attribute such as the color or darkness associated with the first and second symbolic representations, a textual phrase, and so forth.

Operation 408 may include, in various implementations, an operation 409 for adjusting a visual attribute associated with at least one of the first symbolic representation, the second symbolic representation, and the third symbolic representation to indicate strength of the hypothesis as depicted in FIG. 4a. For instance, the visual attribute adjustment module 210* of the mobile device 30 or the computing device 10 adjusting a visual attribute (e.g., adjusting boldness, highlighting, color, spacing or angular relationships between the symbols, and so forth) associated with at least one of the first symbolic representation, the second symbolic representation, and the third symbolic representation to indicate strength of the hypothesis 60. In some implementations, the strength of a hypothesis 60 may be related to confidence level of the hypothesis 60. For instance, a hypothesis 60 that was developed based on a relatively large pool of data that shows a pattern of reported events that have repeatedly occurred and that uniformly supports the hypothesis 60 would result in a stronger or sounder hypothesis 60.

In some alternative implementations, operation 408 may include an operation 410 for indicating visually to the user a fourth symbolic representation representing strength of the hypothesis as depicted in FIG. 4a. For instance, the visual indication module 208* of the mobile device 30 or the computing device 10 indicating visually to the user 20* a fourth symbolic representation (e.g., a number) representing strength (e.g., soundness) of the hypothesis 60.

In various implementations, operation 407 may include an operation 411 for indicating visually to the user a first icon representing the first event type and a second icon representing the second event type as depicted in FIG. 4a. For instance, the visual indication module 208* of the mobile device 30 or the computing device 10 indicating visually to the user 20* a first icon (e.g., an emoticon such as a smiling face) representing the first event type (e.g., happiness) and a second icon (e.g., a figure of the sun) representing the second event type (e.g., sunny weather).

In alternative implementations, operation 407 may include an operation 412 for indicating visually to the user a first textual representation representing the first event type and a second textual representation representing the second event type as depicted in FIG. 4b. For instance, the visual indication module 208* of the mobile device 30 or the computing device 10 indicating visually to the user 20* a first textual representation (e.g., “sadness”) representing the first event type and a second textual representation (e.g., “overcast day”) representing the second event type.

Operation 412, in turn, may include an operation 413 for indicating visually to the user a textual passage including the first and second textual representations, the textual passage representing the relationship between the first event type and the second event type as depicted in FIG. 4b. For instance, the visual indication module 208* of the mobile device 30 or the computing device 10 indicating visually to the user 20* a textual passage including the first and second textual representations, the textual passage representing the relationship between the first event type and the second event type (e.g., “whenever it is cloudy, you are sad”).

In various implementations, the hypothesis presentation operation 302 of FIG. 3 may include an operation 414 for presenting to the user an editable form of the hypothesis as depicted in FIG. 4c. For instance, the editable hypothesis presentation module 212* of the mobile device 30 or the computing device 10 presenting to the user 20* an editable form of the hypothesis 60. For example, in embodiments where the computing device 10 is a server that communicates with a user 20a via the mobile device 30, the editable hypothesis presentation module 212 of the computing device 10 may be designed to present an editable version of the hypothesis 60 to the user 20a by transmitting the editable version of the hypothesis 60 to the mobile device 30. The editable hypothesis presentation module 212′ of the mobile device 30 may then present the editable version of the hypothesis 60 to the user 20a by indicating the editable version of the hypothesis 60 via a user interface 122′ (e.g., a speaker system and/or a display system). The modifications made by the user 20a may then be transmitted back to the computing device 10 for modifying the hypothesis 60

As further depicted in FIG. 4c, in some implementations, operation 414 may include an operation 415 for presenting to the user an editable form of the hypothesis including at least a first editable symbolic representation representing the first event type and a second editable symbolic representation representing the second event type. For instance, the editable hypothesis presentation module 212* of the mobile device 30 or the computing device 10 presenting (e.g., audibly or visually indicating or transmitting via a wireless and/or wired network 40) to the user 20* an editable form of the hypothesis 60 including at least a first editable (e.g., deletable and/or modifiable) symbolic representation representing the first event type and a second editable (e.g., deletable and/or modifiable) symbolic representation representing the second event type.

Operation 415 may, in turn, comprise one or more additional operations in various alternative implementations. For example, in some implementations, operation 415 may include an operation 416 for presenting to the user an editable form of the hypothesis including at least a first deletable symbolic representation representing the first event type and a second deletable symbolic representation representing the second event type as depicted in FIG. 4c. For instance, the editable hypothesis presentation module 212* of the mobile device 30 or the computing device 10 presenting (e.g., audibly or visually indicating or transmitting via a wireless and/or wired network 40) to the user 20* an editable form of the hypothesis 60 including at least a first deletable symbolic representation representing the first event type and a second deletable symbolic representation representing the second event type.

As a further illustration, suppose the user 20* is presented with the editable form of the hypothesis 60 that may have been previously developed based on events previously reported by the user 20* that indicates that the user 20* may get a stomach ache (e.g., a first event type) if the user 20* eats at a particular Mexican restaurant (e.g., a second event type). After being presented with the editable form of the hypothesis 60, the user 20* recognizes that the hypothesis 60 may have been based solely on the user 20* last reported visit to that particular restaurant when the user 20* got sick and now realizes that the cause of his stomach ache may not have been from the visit to that particular restaurant but rather eating a new dish containing a new ingredient he had never eaten before. Thus, the user 20* may want to modify the editable form of the hypothesis 60 to delete one of the event types identified by the hypothesis 60 (e.g., the second symbolic representation representing the second event type that indicates eating at the particular Mexican restaurant) and replacing the deleted event type (or the second symbolic representation) with a new event type (e.g., a third symbolic representation representing the consumption of the new dish containing the new ingredient).

In some implementations, operation 415 may include an operation 417 for presenting to the user an editable form of the hypothesis including at least a first modifiable symbolic representation representing the first event type and a second modifiable symbolic representation representing the second event type as depicted in FIG. 4c. For instance, the editable hypothesis presentation module 212* of the mobile device 30 or the computing device 10 presenting (e.g., audibly or visually indicating or transmitting) to the user 20* an editable form of the hypothesis 60 including at least a first modifiable symbolic representation (e.g., a smiling face emoticon) representing the first event type and a second modifiable symbolic representation (e.g., a picture of clouds) representing the second event type. Such a feature (e.g., providing modifiable symbolic representations) may allow the user 20* to, for example, correct the hypothesis 60 (e.g., changing a smiling face emoticon to a sad face emoticon).

In some implementations, operation 415 may include an operation 418 for presenting to the user an editable form of the hypothesis including at least an editable symbolic representation representing the relationship between the first event type and the second event type as depicted in FIG. 4c. For instance, the editable hypothesis presentation module 212* of the mobile device 30 or the computing device 10 presenting (e.g., audibly or visually indicating or transmitting) to the user 20* an editable form of the hypothesis 60 including at least an editable symbolic representation representing the relationship between the first event type and the second event type.

For example, in some implementations, the editable form of the hypothesis 60 may be presented, for example, on a display monitor in graphical or pictorial form showing a first and a second icon representing the first event type and the second event type. The relationship (e.g., spatial or temporal/specific time relationship) between the first event type and the second event type may be represented in the graphical representation by spacing between the first and the second icon (e.g., the first and second icons being set against a grid background), a line between the first and the second icon, an arrow between the first and the second icon, and so forth, that may be editable. In this example, the symbolic representation representing the relationship between the first event type and the second event type would be the spacing between the first and the second icon, the line between the first and the second icon, the arrow between the first and the second icon, and so forth,

As further depicted in FIG. 4c, in some implementations, operation 418 may include an operation 419 for presenting to the user an editable form of the hypothesis including at least a deletable symbolic representation representing the relationship between the first event type and the second event type as depicted in FIG. 4c. For instance, the editable hypothesis presentation module 212* of the mobile device 30 or the computing device 10 presenting (e.g., audibly or visually indicating or transmitting) to the user 20* an editable form of the hypothesis 60 including at least a deletable symbolic representation representing the relationship between the first event type and the second event type. For example, a pictorial or textual form of the hypothesis 60 may be presented, and at least the portion of the hypothesis 60 that indicates the relationship between the first event type and the second event type may be deletable (e.g., erasable).

In the same or different implementations, operation 418 may include an operation 420 for presenting to the user an editable form of the hypothesis including at least a modifiable symbolic representation representing the relationship between the first event type and the second event type as depicted in FIG. 4c. For instance, the editable hypothesis presentation module 212* of the mobile device 30 or the computing device 10 presenting (e.g., audibly or visually indicating or transmitting) to the user 20* an editable form of the hypothesis 60 including at least a modifiable symbolic representation representing the relationship between the first event type and the second event type. For example, suppose an editable form of the hypothesis 60 is presented in textual form that indicates that the user 20* “will become depressed after overcast weather.” The phrase “after” in the message defines the relationship between the first event type (e.g., depressed) and the second event type (e.g., overcast weather) and may be modifiable (e.g., non-deletion editable) to be switched from “after” to “during.”

In some implementations, operation 414 of FIG. 4c for presenting an editable form of the hypothesis may include an operation 421 for presenting to the user an editable form of the hypothesis including an editable symbolic representation representing a third event type as depicted in FIG. 4d. For instance, the editable hypothesis presentation module 212* of the mobile device 30 or the computing device 10 presenting (e.g., audibly or visually indicating or transmitting) to the user 20* an editable form of the hypothesis 60 including an editable (e.g., deletable and/or modifiable) symbolic representation (e.g., audio or visual representation) representing a third event type (e.g., a subjective user state, an objective occurrence, or a subjective observation).

As further depicted in FIG. 4d, operation 421 may further include, in various implementations, an operation 422 for presenting to the user an editable form of the hypothesis including a deletable symbolic representation representing the third event type. For instance, the editable hypothesis presentation module 212* of the mobile device 30 or the computing device 10 presenting (e.g., audibly or visually indicating or transmitting) to the user 20* an editable form of the hypothesis 60 including a deletable symbolic representation representing the third event type.

In the same or different implementations, operation 421 may include an operation 423 for presenting to the user an editable form of the hypothesis including a modifiable symbolic representation representing the third event type as depicted in FIG. 4d. For instance, the editable hypothesis presentation module 212* of the mobile device 30 or the computing device 10 presenting (e.g., audibly or visually indicating or transmitting) to the user 20* an editable form of the hypothesis 60 a modifiable symbolic representation representing the third event type.

In the same or different implementations, operation 421 may include an operation 424 for presenting to the user an editable form of the hypothesis including another editable symbolic representation representing a fourth event type as depicted in FIG. 4d. For instance, the editable hypothesis presentation module 212* of the mobile device 30 or the computing device 10 presenting (e.g., audibly or visually indicating or transmitting) to the user 20* an editable form of the hypothesis 60 including another editable symbolic representation (e.g., audio or visual representation) representing a fourth event type.

In various implementations, operation 424 may further include an operation 425 for presenting to the user an editable form of the hypothesis including a deletable symbolic representation representing the fourth event type as depicted in FIG. 4d. For instance, the editable hypothesis presentation module 212* of the mobile device 30 or the computing device 10 presenting (e.g., audibly or visually indicating or transmitting) to the user 20* an editable form of the hypothesis 60 including a deletable (e.g. erasable) symbolic representation representing the fourth event type.

In the same or different implementations, operation 424 may include an operation 426 for presenting to the user an editable form of the hypothesis including a modifiable symbolic representation representing the fourth event type as depicted in FIG. 4d. For instance, the editable hypothesis presentation module 212* of the mobile device 30 or the computing device 10 presenting (e.g., audibly or visually indicating or transmitting) to the user 20* an editable form of the hypothesis 60 including a modifiable symbolic representation representing the fourth event type (e.g., a subjective user state, an objective occurrence, or a subjective observation).

Referring back to the hypothesis presentation operation 302 of FIG. 3, in various implementations, the hypothesis presentation operation 302 may provide for one or more options. For example, in some implementations, the hypothesis presentation operation 302 may include an operation 427 for presenting to the user an option to delete the hypothesis as depicted in FIG. 4e. For instance, the hypothesis deletion option presentation module 214* of the mobile device 30 or the computing device 10 presenting to the user 20* an option to delete the hypothesis 60. Such an option may allow a user 20* to delete a hypothesis 60* that the user 20*, for example, feels is irrelevant or wish to ignore.

In the same or different implementations, the hypothesis presentation operation 302 may include an operation 428 for presenting to the user an option to deactivate or ignore the hypothesis as depicted in FIG. 4e. For instance, the hypothesis deactivation option presentation module 216* of the mobile device 30 or the computing device 10 presenting to the user 20* an option to deactivate or ignore the hypothesis 60. By deactivating the hypothesis 60, the action execution module 108* of the mobile device 30 or the computing device 10 may be prevented from executing one or more actions based on the hypothesis 60 (e.g., or a modified version of the hypothesis 60).

Various types of relationships between various types of events may be indicated by the hypothesis 60 presented in the hypothesis presentation operation 302 of FIG. 3. For example, in some implementations, the hypothesis presentation operation 302 may include an operation 429 for presenting to the user a hypothesis identifying at least a time or temporal relationship between the first event type and the second event type as depicted in FIG. 4e. For instance, the hypothesis presentation module 102* of the mobile device 10 or the computing device 10 presenting (e.g., audibly or visually indicating via a user interface 122* or transmitting via wireless and/or wired network 40) to the user 20* a hypothesis 60 identifying at least a time or temporal relationship between the first event type and the second event type. For example, presenting to the user 20* a hypothesis 60 in textual form that indicates that “whenever the user's friend borrows the car, the car always appears to run worse afterwards.” In this example, “the user's friend borrows the car” represents the first event type, “the car always appears to run worse” represents the second event type, and the “afterwards” represents the temporal relationship between the first event type and the second event type.

In some implementations, the hypothesis presentation operation 302 may include an operation 430 for presenting to the user a hypothesis identifying at least a spatial relationship between the first event type and the second event type as depicted in FIG. 4e. For instance, the hypothesis presentation module 102* of the mobile device 30 or the computing device 10 presenting (e.g., audibly or visually indicating via a user interface 122* or transmitting via wireless and/or wired network 40) to the user 20* a hypothesis 60 identifying at least a spatial relationship between the first event type and the second event type. For example, presenting to the user 20* a hypothesis 60 in audio form that indicates that “whenever the spouse is working in another city, and the user is at home, the user is happy.” In this example, “the spouse is working” may represent the first event type, “the user is happy” may represent the second event type, and the spouse working in another city and the “user is at home” may represent the spatial relationship between the first event type and the second event type.

In some implementations, the hypothesis presentation operation 302 may include an operation 431 for presenting to the user a hypothesis identifying at least a relationship between at least a first subjective user state type and a second subjective user state type as depicted in FIG. 4e. For instance, the hypothesis presentation module 102* of the mobile device 30 or the computing device 10 presenting (e.g., audibly or visually indicating via a user interface 122* or transmitting via wireless and/or wired network 40) to the user 20* a hypothesis 60 identifying at least a relationship between at least a first subjective user state type (e.g., anger) and a second subjective user state type (e.g., sore or stiff back).

In some implementations, the hypothesis presentation operation 302 may include an operation 432 for presenting to the user a hypothesis identifying at least a relationship between at least a subjective user state type and a subjective observation type as depicted in FIG. 4e. For instance, the hypothesis presentation module 102* of the mobile device 30 or the computing device 10 presenting (e.g., audibly or visually indicating via a user interface 122* or transmitting via wireless and/or wired network 40) to the user 20* a hypothesis 60 identifying at least a relationship between at least a subjective user state type (e.g., tension) and a subjective observation type (e.g., boss appears to be angry).

In some implementations, the hypothesis presentation operation 302 may include an operation 433 for presenting to the user a hypothesis identifying at least a relationship between at least a subjective user state type and an objective occurrence type as depicted in FIG. 4e. For instance, the hypothesis presentation module 102* of the mobile device 30 or the computing device 10 presenting (e.g., audibly or visually indicating via a user interface 122* or transmitting via wireless and/or wired network 40) to the user 20* a hypothesis 60 identifying at least a relationship between at least a subjective user state type (e.g., fatigue) and an objective occurrence type (e.g., alcoholic consumption).

In some implementations, the hypothesis presentation operation 302 may include an operation 434 for presenting to the user a hypothesis identifying at least a relationship between at least a first subjective observation type and a second subjective observation type as depicted in FIG. 4e. For instance, the hypothesis presentation module 102* of the mobile device 30 or the computing device 10 presenting (e.g., audibly or visually indicating via a user interface 122* or transmitting via wireless and/or wired network 40) to the user 20* a hypothesis 60 identifying at least a relationship between at least a first subjective observation type (e.g., pet dog appears to be depressed) and a second subjective observation type (e.g., spouse appears to be depressed).

In some implementations, the hypothesis presentation operation 302 may include an operation 435 for presenting to the user a hypothesis identifying at least a relationship between at least a subjective observation type and an objective occurrence type as depicted in FIG. 4e. For instance, the hypothesis presentation module 102* of the mobile device 30 or the computing device 10 presenting (e.g., audibly or visually indicating via a user interface 122* or transmitting via wireless and/or wired network 40) to the user 20* a hypothesis 60 identifying at least a relationship between at least a subjective observation type (e.g., sore ankles) and an objective occurrence type (e.g., jogging).

In some implementations, the hypothesis presentation operation 302 may include an operation 436 for presenting to the user a hypothesis identifying at least a relationship between at least a first objective occurrence type and a second objective occurrence type as depicted in FIG. 4f. For instance, the hypothesis presentation module 102* of the mobile device 30 or the computing device 10 presenting (e.g., audibly or visually indicating via a user interface 122* or transmitting via wireless and/or wired network 40) a hypothesis 60 identifying at least a relationship between at least a first objective occurrence type (e.g., elevated blood glucose level) and a second objective occurrence type (e.g., consumption of a particular type of food).

In various implementations, the hypothesis to be presented through the hypothesis presentation operation 302 of FIG. 3 may have been developed based on data (e.g., events data that indicate previously reported events) provided by a user 20*. For example, in some implementations, the hypothesis presentation operation 302 may include an operation 437 for presenting to the user a hypothesis that was developed based, at least in part, on data provided by the user as depicted in FIG. 4f. For instance, the hypothesis presentation module 102* of the mobile device 30 or the computing device 10 presenting (e.g., audibly or visually indicating via a user interface 122* or transmitting via wireless and/or wired network 40) to the user 20* a hypothesis 60 that was developed based, at least in part, on data provided by the user 20*. As a further illustration, a hypothesis 60* may be developed by, for example, the reported event reception module 110 of the computing device 10 receiving data that indicates reported events reported by the user 20*. Based on this data, and based at least in part on a pattern of reported events (e.g., spatial or temporal/time pattern of reported events) or reoccurring pattern of reported events identified by the hypothesis development module 112, the hypothesis development module 112 may develop a hypothesis 60.

The hypothesis to be presented through the hypothesis presentation operation 302 of FIG. 3 may be directed to various subjects in various alternative implementations. For example, in some implementations, the hypothesis presentation module 302 may include an operation 438 for presenting to the user a hypothesis relating to the user as depicted in FIG. 4f. For instance, the hypothesis presentation module 102* of the mobile device 30 or the computing device 10 presenting (e.g., audibly or visually indicating or transmitting) to the user 20* a hypothesis 60 relating to the user 20*. For example, presenting to the user 20* a hypothesis 60 that indicates a relationship between a subjective user state of the user 20* with consumption of a particular food item by the user 20*.

In some implementations, the hypothesis presentation operation 302 may include an operation 439 for presenting to the user a hypothesis relating to a third party as depicted in FIG. 4f. For instance, the hypothesis presentation module 102* of the mobile device 30 or the computing device 10 presenting (e.g., audibly or visually indicating or transmitting) to the user 20* a hypothesis 60 relating to a third party. For example, presenting to the user 20* a hypothesis 60 that indicates a relationship between a subjective user state of a third party (e.g., a pet such as a dog, livestock, a spouse, a friend, and so forth) with consumption of a particular food item by the third party.

In some implementations, the hypothesis presentation operation 302 may include an operation 440 for presenting to the user a hypothesis relating to a device as depicted in FIG. 4f. For instance, the hypothesis presentation module 102* of the mobile device 30 or the computing device 10 presenting (e.g., audibly or visually indicating or transmitting) to the user 20* a hypothesis 60 relating to a device. For example, presenting to the user 20* a hypothesis 60 that indicates a relationship between the use of a personal computer by an offspring and the prevalence of computer viruses in the personal computer afterwards.

In some implementations, the hypothesis presentation operation 302 may include an operation 441 for presenting to the user a hypothesis relating to one or more environmental characteristics as depicted in FIG. 4f. For instance, the hypothesis presentation module 102* of the mobile device 30 or the computing device 10 presenting (e.g., audibly or visually indicating or transmitting) to the user 20* a hypothesis 60 relating to one or more environmental characteristics. For example, presenting to the user 20* a hypothesis 60 that indicates a relationship between the local atmospheric pollution level (e.g., as sensed by pollution monitoring devices including those that measure gas and/or particulate levels in the atmosphere) and when a particular factory is in operation.

In various embodiments, the hypothesis 60 to be presented through the hypothesis presentation operation 302 of FIG. 3 may be directed or related to three or more event types (e.g., types of events). For example, in some implementations, the hypothesis presentation operation 302 may include an operation 442 for presenting to the user a hypothesis identifying at least relationships between the first event type, the second event type, and a third event type as depicted in FIG. 4f. For instance, the hypothesis presentation module 102* of the mobile device 30 or the computing device 10 presenting (e.g., audibly or visually indicating or transmitting) to the user 20* a hypothesis 60 identifying at least relationships between the first event type, the second event type, and a third event type. For example, presenting a hypothesis 60 that identifies temporal relationships between eating ice cream, drinking coffee, and having a stomach ache.

In various implementations, operation 442 may further include an operation 443 for presenting to the user a hypothesis identifying at least relationships between the first event type, the second event type, the third event type, and a fourth event type as depicted in FIG. 4f. For instance, the hypothesis presentation module 102* of the mobile device 30 or the computing device 10 presenting (e.g., audibly or visually indicating or transmitting) to the user 20* a hypothesis 60 identifying at least relationships between the first event type, the second event type, the third event type, and a fourth event type. For example, presenting a hypothesis 60 that identifies temporal relationships between eating ice cream (e.g., first event type), drinking coffee (e.g., second event type), waking-up late (e.g., third event type), and having a stomach ache (e.g., fourth event type). Note that in this illustration, the user 20* after being presented with the hypothesis 60 may determine that the third event type, waking-up late, may not be relevant with respect to the hypothesis 60 (e.g., things that may be linked to a stomach ache). As a result, the user 20*, as will be further described below, may delete the third event type from the hypothesis 60.

Referring back to the modification reception operation 304 of FIG. 3, the one or more modifications received through the modification reception operation 304 may be received in a variety of different ways. For example, in various implementations, the modification reception operation 304 may include an operation 544 for receiving the one or more modifications via a user interface as depicted in FIG. 5a. For instance, the user interface reception module 218* of the mobile device 30 or the computing device 10 (e.g., in embodiments in which the computing device 10 is a standalone device) receiving the one or more modifications 61 via a user interface 122* (e.g., a microphone, a touch screen, a keypad, a mouse, and so forth).

In some implementations, operation 544 may further include an operation 545 for transmitting the one or more modifications to a server via at least one of a wireless network and a wired network as depicted in FIG. 5a. For instance, the modification transmission module 219 of the mobile device 30 transmitting (e.g., via a wireless and/or wired network 40) the one or more modifications 61 to a server (e.g., computing device 10 in embodiments in which the computing device 10 is a server) via at least one of a wireless network and a wired network (e.g., via a wireless and/or wired network 40).

In some implementations, the modification reception operation 304 may include an operation 546 for receiving the one or more modifications from at least one of a wireless network and a wired network as depicted in FIG. 5a. For instance, the network reception module 220 of the computing device 10 (e.g., in embodiments where the computing device 10 is a server) receiving the one or more modifications 61 (e.g., as provided by the mobile device 30) from at least one of a wireless network and a wired network 40 (e.g., a wireless and/or wired network 40).

The one or more modifications received through the modification reception operation 304 of FIG. 3 may be received in a variety of different forms. For example, in some implementations, the modification reception operation 304 may include an operation 547 for receiving the one or more modifications via one or more electronic entries as provided by the user as depicted in FIG. 5a. For instance, the electronic entry reception module 222* of the mobile device 30 or the computing device 10 receiving (e.g., receiving directly via a user interface 122* or indirectly via a wireless and/or wired network 40) the one or more modifications 61 via one or more electronic entries as provided by the user 20*.

In some implementations, operation 547 may include an operation 548 for receiving the one or more modifications via one or more blog entries as provided by the user as depicted in FIG. 5a. For instance, the blog entry reception module 224* of the mobile device 30 or the computing device 10 receiving (e.g., receiving directly via a user interface 122* or indirectly via a wireless and/or wired network 40) the one or more modifications 61 via one or more blog entries (e.g., microblog entries) as provided by the user 20*.

In some implementations, operation 547 may include an operation 549 for receiving the one or more modifications via one or more status reports as provided by the user as depicted in FIG. 5a. For instance, the status report reception module 226* of the mobile device 30 or the computing device 10 receiving (e.g., receiving directly via a user interface 122* or indirectly via a wireless and/or wired network 40) the one or more modifications 61 via one or more (social networking) status reports as provided by the user 20*.

In some implementations, operation 547 may include an operation 550 for receiving the one or more modifications via one or more electronic messages as provided by the user as depicted in FIG. 5a. For instance, the electronic message reception module 228* of the mobile device 30 or the computing device 10 receiving (e.g., receiving directly via a user interface 122* or indirectly via a wireless and/or wired network 40) the one or more modifications 61 via one or more electronic messages (e.g., emails, text messages, IM messages, and so forth) as provided by the user 20*.

In some implementations, operation 547 may include an operation 551 for receiving the one or more modifications via one or more diary entries as provided by the user as depicted in FIG. 5a. For instance, the diary entry reception module 230* of the mobile device 30 or the computing device 10 receiving (e.g., receiving directly via a user interface 122* or indirectly via a wireless and/or wired network 40) the one or more modifications 61 via one or more diary entries as provided by the user 20*.

Various types of modifications may be received through the modification reception operation 304 of FIG. 3 in various alternative implementations. For example, in some implementations, the modification reception operation 304 may include an operation 552 for receiving from the user a modification to delete a third event type from the hypothesis as depicted in FIG. 5a. For instance, the modification reception module 104* of the mobile device 30 or the computing device 10 receiving from the user 20* a modification 61 to delete a third event type from the hypothesis 60.

In certain implementations, operation 552 may further include an operation 553 for receiving from the user a modification to delete at least a fourth event type from the hypothesis as depicted in FIG. 5a. For instance, the modification reception module 104* of the mobile device 30 or the computing device 10 receiving from the user 20* a modification 61 to delete at least a fourth event type from the hypothesis 60.

In various implementations, the modification reception operation 304 of FIG. 3 may include an operation 554 for receiving from the user a modification to add to the hypothesis a third event type with respect to the first event type and the second event type as depicted in FIG. 5b. For instance, the modification reception module 104* of the mobile device 30 or the computing device 10 receiving from the user 20* a modification 61 to add to the hypothesis 60 a third event type with respect to the first event type and the second event type. In other words, a modification to add to the hypothesis 60 a third event type and its spatial or time occurrence relative to the occurrences of the first event type and the second event type as indicated by the hypothesis 60.

In some implementations, operation 554 may further include an operation 555 for receiving from the user a modification to add to the hypothesis at least a fourth event type with respect to the first event type and the second event type, and with respect to the third event type to be added to the hypothesis as depicted in FIG. 5b. For instance, the modification reception module 104* of the mobile device 30 or the computing device 10 receiving from the user 20* a modification 61 to add to the hypothesis 60 at least a fourth event type with respect to the first event type and the second event type, and with respect to the third event type to be added to the hypothesis 60.

In various implementations, the modification reception operation 304 of FIG. 3 may include an operation 556 for receiving from the user a modification to revise the first event type of the hypothesis as depicted in FIG. 5b. For instance, the modification reception module 104* of the mobile device 30 or the computing device 10 receiving from the user 20* a modification 61 to revise the first event type of the hypothesis 60* (e.g., revising a subjective user state such as “anger” to another subjective user state such as “disappointment”).

In some implementations, operation 556 may further include an operation 557 for receiving from the user a modification to revise the second event type of the hypothesis as depicted in FIG. 5b. For instance, the modification reception module 104* of the mobile device 30 or the computing device 10 receiving from the user 20* a modification to revise the second event type of the hypothesis 60 (e.g., an objective occurrence such as a co-worker not coming to work to another objective occurrence such as a co-worker coming to work late).

In some implementations, the modification reception operation 304 of FIG. 3 may include an operation 558 for receiving from the user a modification to revise the relationship between the first event type and the second event type as depicted in FIG. 5b. For instance, the modification reception module 104* of the mobile device 30 or the computing device 10 receiving from the user 20* a modification 61 to revise the relationship between the first event type and the second event type (e.g., changing the temporal relationship between the first event type and the second event type as indicated by the hypothesis 60).

In some implementations, the modification reception operation 304 may include an operation 559 for receiving from the user a modification to modify at least one of the first event type and the second event type including at least one type of subjective user state as depicted in FIG. 5b. For instance, the modification reception module 104* of the mobile device 30 or the computing device 10 receiving from the user 20* a modification 61 to modify at least one of the first event type and the second event type including at least one type of subjective user state (e.g., a subjective user state, a subjective physical state, or a subjective overall state).

In some implementations, the modification reception operation 304 may include an operation 560 for receiving from the user a modification to modify at least one of the first event type and the second event type including at least one type of subjective observation as depicted in FIG. 5b. For instance, the modification reception module 104* of the mobile device 30 or the computing device 10 receiving from the user 20* a modification 61 to modify at least one of the first event type and the second event type including at least one type of subjective observation (e.g., perceived subjective user state of a third party, a subjective observation or opinion regarding an external activity, a user's activity, or a third party's activity, a subjective observation or opinion regarding performance or characteristic of a device, and so forth).

In some implementations, the modification reception operation 304 may include an operation 561 for receiving from the user a modification to modify at least one of the first event type and the second event type including at least one type of objective occurrence as depicted in FIG. 5b. For instance, the modification reception module 104* of the mobile device 30 or the computing device 10 receiving from the user 20* a modification 61 to modify at least one of the first event type and the second event type including at least one type of objective occurrence (e.g., consumption of a food item, medicine, or nutraceutical by the user 20* or by a third party 50, an activity executed by the user 20* or by a third party 50, an external activity, an objectively measurable physical characteristic of the user 20* or of a third party 50, and so forth).

In some implementations, the modification reception operation 304 may include an operation 562 for modifying the hypothesis based on the one or more modifications to generate the modified hypothesis as depicted in FIG. 5b. For instance, the hypothesis modification module 106 of the computing device 10 modifying the hypothesis 60 based on the one or more modifications 61 (e.g., as received by the modification reception module 104 of the computing device 10) to generate the modified hypothesis 80.

Referring back to the action execution operation 306 of FIG. 3, various types of actions may be executed in action execution operation 306 in various alternative implementations. For example, in some implementations, the action execution operation 306 may include an operation 663 for presenting one or more advisories relating to the modified hypothesis as depicted in FIG. 6a. For instance, the advisory presentation module 232* of the mobile device 30 or the computing device 10 presenting (e.g., indicating via a user interface 122* or transmitting via a wireless and/or wired network 40) one or more advisories 90 relating to the modified hypothesis 80.

Various types of advisories may be presented through operation 663. For example, in some implementations, operation 663 may include an operation 664 for indicating the one or more advisories relating to the modified hypothesis via user interface as depicted in FIG. 6a. For instance, the user interface indication module 234* of the mobile device 30 or the computing device 10 indicating (e.g., audibly indicating and/or visually displaying) the one or more advisories 90 relating to the modified hypothesis 80 via user interface 122* (e.g., an audio system including one or more speakers and/or a display system including a display monitor or touch screen).

In some selective implementations, operation 664 may include an operation 665 for receiving the one or more advisories from a server prior to said indicating as depicted in FIG. 6a. For instance, the advisory reception module 235 of the mobile device 30 receiving the one or more advisories 90 from a server (e.g., the computing device 10 in embodiments where the computing device 10 is a network server) prior to said indicating of the one or more advisories 90.

In the same or different implementations, operation 663 may include an operation 666 for transmitting the one or more advisories related to the modified hypothesis via at least one of a wireless network and a wired network as depicted in FIG. 6a. For instance, the network transmission module 236* of the mobile device 30 or the computing device 10 transmitting the one or more advisories 90 related to the modified hypothesis 80 via at least one of a wireless network and a wired network 40. Note that, in addition to or instead of presenting the one or more advisories 90 to the user 20*, the one or more advisories 90 may be transmitted by the mobile device 30 or the computing device 10 to, for example, one or more third parties 50.

In various implementations, operation 666 may further include an operation 667 for transmitting the one or more advisories related to the modified hypothesis to the user as depicted in FIG. 6a. For instance, the network transmission module 236 of the computing device 10 (e.g., in embodiments in which the computing device 10 is a server) transmitting the one or more advisories 90 related to the modified hypothesis 80 to the user 20a.

In some implementations, operation 666 may include an operation 668 for transmitting the one or more advisories related to the modified hypothesis to one or more third parties as depicted in FIG. 6a. For instance, the network transmission module 236* of the mobile device 30 or the computing device 10 transmitting the one or more advisories 90 related to the modified hypothesis 80 to one or more third parties 50.

In various implementations, the modified hypothesis 80 may be presented through operation 663. For example, in some implementations, operation 663 may include an operation 669 for presenting at least one form of the modified hypothesis as depicted in FIG. 6a. For instance, the modified hypothesis presentation module 238* of the mobile device 30 or the computing device 10 presenting at least one form (e.g., audio form and/or visual form such as textual, graphical, or pictorial form) of the modified hypothesis 80.

Operation 669, in turn, may include an operation 670 for presenting an indication of a relationship between at least two event types as indicated by the modified hypothesis as depicted in FIG. 6a. For instance, the modified hypothesis presentation module 238* of the mobile device 30 or the computing device 10 presenting (e.g., indicating via a user interface 122 or transmitting via wireless and/or wired network 40) an indication of a relationship (e.g., spatial or temporal/specific time relationship) between at least two event types as indicated by the modified hypothesis 80.

In some implementations, operation 670 may include an operation 671 for presenting an indication of a temporal or specific time relationship between the at least two event types as indicated by the modified hypothesis as depicted in FIG. 6a. For instance, the modified hypothesis presentation module 238* of the mobile device 30 or the computing device 10 presenting an indication of a temporal or specific time relationship between the at least two event types as indicated by the modified hypothesis 80.

In the same or alternative implementations, operation 670 may include an operation 672 for presenting an indication of a spatial relationship between the at least two event types as indicated by the modified hypothesis as depicted in FIG. 6a. For instance, the modified hypothesis presentation module 238* of the mobile device 30 or the computing device 10 presenting an indication of a spatial relationship between the at least two event types as indicated by the modified hypothesis 80.

In the same or different implementations, operation 670 may include an operation 673 for presenting an indication of a relationship between at least a first type of subjective user state and a second type of subjective user state as indicated by the modified hypothesis as depicted in FIG. 6a. For instance, the modified hypothesis presentation module 238* of the mobile device 30 or the computing device 10 presenting an indication of a relationship between at least a first type of subjective user state (e.g., jealousy) and a second type of subjective user state (e.g., depression) as indicated by the modified hypothesis 80.

In the same or different implementations, operation 670 may include an operation 674 for presenting an indication of a relationship between at least a type of subjective user state and a type of objective occurrence as indicated by the modified hypothesis as depicted in FIG. 6b. For instance, the modified hypothesis presentation module 238* of the mobile device 30 or the computing device 10 presenting an indication of a relationship between at least a type of subjective user state (e.g., subjective overall state such as “great”) and a type of objective occurrence (e.g., fishing) as indicated by the modified hypothesis 80.

In the same or different implementations, operation 670 may include an operation 675 for presenting an indication of a relationship between at least a type of subjective user state and a type of subjective observation as indicated by the modified hypothesis as depicted in FIG. 6b. For instance, the modified hypothesis presentation module 238* of the mobile device 30 or the computing device 10 presenting an indication of a relationship between at least a type of subjective user state (e.g., fear) and a type of subjective observation (e.g., spouse perceived to be angry) as indicated by the modified hypothesis 80.

In the same or different implementations, operation 670 may include an operation 676 for presenting an indication of a relationship between at least a first type of objective occurrence and a second type of objective occurrence as indicated by the modified hypothesis as depicted in FIG. 6b. For instance, the modified hypothesis presentation module 238* of the mobile device 30 or the computing device 10 presenting an indication of a relationship between at least a first type of objective occurrence (e.g., off-spring parents' car) and a second type of objective occurrence (e.g., low fuel level in the car) as indicated by the modified hypothesis 80.

In the same or different implementations, operation 670 may include an operation 677 for presenting an indication of a relationship between at least a type of objective occurrence and a type of subjective observation as indicated by the modified hypothesis as depicted in FIG. 6b. For instance, the modified hypothesis presentation module 238* of the mobile device 30 or the computing device 10 presenting an indication of a relationship between at least a type of objective occurrence (e.g., staying home on wedding anniversary) and a type of subjective observation (e.g., spouse appears to be in bad mood) as indicated by the modified hypothesis 80.

In the same or different implementations, operation 670 may include an operation 678 for presenting an indication of a relationship between at least a first type of subjective observation and a second type of subjective observation as indicated by the modified hypothesis as depicted in FIG. 6b. For instance, the modified hypothesis presentation module 238* of the mobile device 30 or the computing device 10 presenting an indication of a relationship between at least a first type of subjective observation (e.g., “bad weather”) and a second type of subjective observation (e.g., spouse appears to be in bad mood) as indicated by the modified hypothesis 80.

In various implementations, operation 663 of FIG. 6a for presenting one or more advisories 90 may include an operation 679 for presenting an advisory relating to a predication of one or more future events based, at least in part, on the modified hypothesis as depicted in FIG. 6c. For instance, the prediction presentation module 240* of the mobile device 30 or the computing device 10 presenting (e.g., indicating via a user interface 122* or transmitting via a wireless and/or wired network 40) an advisory 90 relating to a predication of one or more future events (e.g., “you will have a headache tomorrow morning because you drank last night”) based, at least in part, on the modified hypothesis 80.

In various implementations, operation 663 may include an operation 680 for presenting a recommendation for a future course of action based, at least in part, on the modified hypothesis as depicted in FIG. 6c. For instance, the recommendation presentation module 242* of the mobile device 30 or the computing device 10 presenting (e.g., indicating via a user interface 122* or transmitting via a wireless and/or wired network 40) a recommendation for a future course of action (e.g., “you should bring aspirin to work tomorrow”) based, at least in part, on the modified hypothesis 80.

In some implementations, operation 680 may further include an operation 681 for presenting a justification for the recommendation as depicted in FIG. 6c. For instance, the justification presentation module 244* of the mobile device 30 or the computing device 10 presenting a justification for the recommendation (e.g., “you should bring aspirin to work tomorrow because you drank 12 mugs of beer tonight”).

In some implementations, operation 663 may include an operation 682 for presenting an indication of one or more past events based, at least in part, on the modified hypothesis as depicted in FIG. 6c. For instance, the past event presentation module 246* of the mobile device 30 or the computing device 10 presenting (e.g., indicating via a user interface 122* or transmitting via a wireless and/or wired network 40) an indication of one or more past events based, at least in part, on the modified hypothesis 80 (e.g., “the last time you drank 12 mugs of beer, you had a hangover the next morning”).

Referring back to the action execution operation 306 of FIG. 3, the action execution operation 306, in various alternative implementations, may include prompting 91* one or more devices to execute one or more operations. For example, in some implementations, the action execution operation 306 may include an operation 683 for prompting one or more devices to execute one or more operations based, at least in part, on the modified hypothesis as depicted in FIG. 6d. For instance, the device prompting module 248* of the mobile device 30 or the computing device 10 prompting 91* one or more devices (e.g., network and/or local devices 55 and/or sensing devices 35*) to execute one or more operations based, at least in part, on the modified hypothesis 80.

Various techniques may be employed in order to prompt one or more devices to execute one or more operations in various alternative implementations. For example, in some implementations, operation 683 may include an operation 684 for instructing the one or more devices to execute the one or more operations as depicted in FIG. 6d. For instance, the device instruction module 250* of the mobile device 30 or the computing device 10 instructing the one or more devices (e.g., directly instructing a local device or indirectly instructing a remote network device via wireless and/or wired network 40) to execute the one or more operations. As an illustration, instructing a home appliance or a sensing device 35* to execute one or more operations in accordance with instructions provided by the device instruction module 250*.

In some implementations, operation 683 may include an operation 685 for activating the one or more devices to execute the one or more operations as depicted in FIG. 6d. For instance, the device activation module 252* of the mobile device 30 or the computing device 10 activating (e.g., directly activating a local device or indirectly activating a network device via wireless and/or wired network 40) the one or more devices (e.g., a home environmental device such as an air conditioner or an air purifier) to execute the one or more operations.

In some implementations, operation 683 may include an operation 686 for configuring the one or more devices to execute the one or more operations as depicted in FIG. 6d. For instance, the device configuration module 254* of the mobile device 30 or the computing device 10 configuring (e.g., directly configuring a local device or indirectly configuring a network device via wireless and/or wired network 40) the one or more devices (e.g., a personal device such as the mobile device 30 or a standalone computing device 10) to execute the one or more operations.

Various types of devices may be prompted through operation 683 in various alternative implementations. For example, in some implementations, operation 683 may include an operation 687 for prompting one or more environmental devices to execute the one or more operations as depicted in FIG. 6d. For instance, the device prompting module 248* of the mobile device 30 or the computing device 10 prompting 91* one or more environmental devices (e.g., air conditioner, humidifier, air purifier, and so forth) to execute the one or more operations.

In some implementations, operation 683 may include an operation 688 for prompting one or more household devices to execute the one or more operations as depicted in FIG. 6d. For instance, the device prompting module 250* of the mobile device 30 or the computing device 10 prompting one or more household devices (e.g., a television, hot water heater, lawn sprinkler system, and so forth) to execute the one or more operations.

In some implementations, operation 683 may include an operation 689 for prompting one or more sensing devices to execute the one or more operations as depicted in FIG. 6d. For instance, the device prompting module 248* of the mobile device 30 or the computing device 10 prompting 91* one or more sensing devices 35* to execute (e.g., physical or physiological sensing devices, environmental sensing devices, GPSs, pedometers, accelerometers, and so forth) the one or more operations.

In some implementations, operation 683 may include an operation 690 for prompting one or more network devices to execute the one or more operations as depicted in FIG. 6d. For instance, the device prompting module 248* of the mobile device 30 or the computing device 10 prompting one or more network devices (e.g., devices that can interface with a wireless and/or wired network 40) to execute the one or more operations.

Referring back to the action execution operation 306 of FIG. 3, in various implementations, the one or more actions to be executed through action execution operation 306 may be executed in response to receiving a request or instructions from network device such as a server. For example, in some implementations, the action execution operation 306 may include an operation 691 for executing the one or more actions based, at least in part, on a request or instructions received from a server as depicted in FIG. 6d. For instance, the action execution module 108′ of the mobile device 30 executing the one or more actions based, at least in part, on a request or instructions received (e.g., as received by the request/instruction reception module 237 of the mobile device 30) from a server (e.g., computing device 10 in embodiments where the computing device 10 is a network server).

The one or more actions to be executed in the action execution operation 306 of FIG. 3 may be in response to a reported event in addition to being based at least in part to the modified hypothesis 80. For example, in various implementations, the action execution operation 306 may include an operation 692 for executing the one or more actions based on the modified hypothesis and in response to a reported event as depicted in FIG. 6e. For instance, the action execution module 108* of the mobile device 30 or the computing device 10 executing the one or more actions based on the modified hypothesis 80 and in response to a reported event (e.g., in response to the reported event reception module 110* of the mobile device 30 or the computing device 10 receiving data indicating a reported event).

In some implementations, operation 692 may further include an operation 693 for executing the one or more actions based on the modified hypothesis and in response to a reported event that at least substantially matches with one of at least two event types identified by the modified hypothesis as depicted in FIG. 6e. For instance, the action execution module 108* of the mobile device 30 or the computing device 10 executing the one or more actions based on the modified hypothesis 80 and in response to a reported event that substantially matches with one of at least two event types identified by the modified hypothesis 80. To illustrate, suppose the modified hypothesis 80 indicates a relationship between eating a particular Mexican dish at a particular restaurant (e.g., an event type) with a stomach ache (e.g., another event type). Under this scenario, the action execution module 108* may execute an action (e.g., indicate a warning about a pending stomach ache) if it is reported that a similar Mexican dish was consumed at the same restaurant (e.g., reported event).

Operation 693, in turn, may further include an operation 694 for executing the one or more actions based on the modified hypothesis and in response to a reported event that matches with one of the at least two event types identified by the modified hypothesis as depicted in FIG. 6e. For instance, the action execution module 108* of the mobile device 30 or the computing device 10 executing the one or more actions based on the modified hypothesis 80 and in response to a reported event (e.g., in response to the reported event reception module 110* of the mobile device 30 or the computing device 10 receiving data indicating a reported event) that matches with one of the at least two event types identified by the modified hypothesis 80. To illustrate, suppose the modified hypothesis 80 indicates a relationship between exercising on a treadmill (e.g., an event type) and feeling hot (e.g., another event type). Under this scenario, the action execution module 108* may execute an action (e.g., configuring an air conditioner to operate at full power) if it is reported that the treadmill was used for exercising (e.g., reported event).

Those having skill in the art will recognize that the state of the art has progressed to the point where there is little distinction left between hardware and software implementations of aspects of systems; the use of hardware or software is generally (but not always, in that in certain contexts the choice between hardware and software can become significant) a design choice representing cost vs. efficiency tradeoffs. Those having skill in the art will appreciate that there are various vehicles by which processes and/or systems and/or other technologies described herein can be effected (e.g., hardware, software, and/or firmware), and that the preferred vehicle will vary with the context in which the processes and/or systems and/or other technologies are deployed. For example, if an implementer determines that speed and accuracy are paramount, the implementer may opt for a mainly hardware and/or firmware vehicle; alternatively, if flexibility is paramount, the implementer may opt for a mainly software implementation; or, yet again alternatively, the implementer may opt for some combination of hardware, software, and/or firmware. Hence, there are several possible vehicles by which the processes and/or devices and/or other technologies described herein may be effected, none of which is inherently superior to the other in that any vehicle to be utilized is a choice dependent upon the context in which the vehicle will be deployed and the specific concerns (e.g., speed, flexibility, or predictability) of the implementer, any of which may vary. Those skilled in the art will recognize that optical aspects of implementations will typically employ optically-oriented hardware, software, and or firmware.

The foregoing detailed description has set forth various embodiments of the devices and/or processes via the use of block diagrams, flowcharts, and/or examples. Insofar as such block diagrams, flowcharts, and/or examples contain one or more functions and/or operations, it will be understood by those within the art that each function and/or operation within such block diagrams, flowcharts, or examples can be implemented, individually and/or collectively, by a wide range of hardware, software, firmware, or virtually any combination thereof. In one embodiment, several portions of the subject matter described herein may be implemented via Application Specific Integrated Circuits (ASICs), Field Programmable Gate Arrays (FPGAs), digital signal processors (DSPs), or other integrated formats. However, those skilled in the art will recognize that some aspects of the embodiments disclosed herein, in whole or in part, can be equivalently implemented in integrated circuits, as one or more computer programs running on one or more computers (e.g., as one or more programs running on one or more computer systems), as one or more programs running on one or more processors (e.g., as one or more programs running on one or more microprocessors), as firmware, or as virtually any combination thereof, and that designing the circuitry and/or writing the code for the software and or firmware would be well within the skill of one of skill in the art in light of this disclosure. In addition, those skilled in the art will appreciate that the mechanisms of the subject matter described herein are capable of being distributed as a program product in a variety of forms, and that an illustrative embodiment of the subject matter described herein applies regardless of the particular type of signal bearing medium used to actually carry out the distribution. Examples of a signal bearing medium include, but are not limited to, the following: a recordable type medium such as a floppy disk, a hard disk drive, a Compact Disc (CD), a Digital Video Disk (DVD), a digital tape, a computer memory, etc.; and a transmission type medium such as a digital and/or an analog communication medium (e.g., a fiber optic cable, a waveguide, a wired communications link, a wireless communication link, etc.).

In a general sense, those skilled in the art will recognize that the various aspects described herein which can be implemented, individually and/or collectively, by a wide range of hardware, software, firmware, or any combination thereof can be viewed as being composed of various types of “electrical circuitry.” Consequently, as used herein “electrical circuitry” includes, but is not limited to, electrical circuitry having at least one discrete electrical circuit, electrical circuitry having at least one integrated circuit, electrical circuitry having at least one application specific integrated circuit, electrical circuitry forming a general purpose computing device configured by a computer program (e.g., a general purpose computer configured by a computer program which at least partially carries out processes and/or devices described herein, or a microprocessor configured by a computer program which at least partially carries out processes and/or devices described herein), electrical circuitry forming a memory device (e.g., forms of random access memory), and/or electrical circuitry forming a communications device (e.g., a modem, communications switch, or optical-electrical equipment). Those having skill in the art will recognize that the subject matter described herein may be implemented in an analog or digital fashion or some combination thereof.

Those having skill in the art will recognize that it is common within the art to describe devices and/or processes in the fashion set forth herein, and thereafter use engineering practices to integrate such described devices and/or processes into data processing systems. That is, at least a portion of the devices and/or processes described herein can be integrated into a data processing system via a reasonable amount of experimentation. Those having skill in the art will recognize that a typical data processing system generally includes one or more of a system unit housing, a video display device, a memory such as volatile and non-volatile memory, processors such as microprocessors and digital signal processors, computational entities such as operating systems, drivers, graphical user interfaces, and applications programs, one or more interaction devices, such as a touch pad or screen, and/or control systems including feedback loops and control motors (e.g., feedback for sensing position and/or velocity; control motors for moving and/or adjusting components and/or quantities). A typical data processing system may be implemented utilizing any suitable commercially available components, such as those typically found in data computing/communication and/or network computing/communication systems.

The herein described subject matter sometimes illustrates different components contained within, or connected with, different other components. It is to be understood that such depicted architectures are merely exemplary, and that in fact many other architectures can be implemented which achieve the same functionality. In a conceptual sense, any arrangement of components to achieve the same functionality is effectively “associated” such that the desired functionality is achieved. Hence, any two components herein combined to achieve a particular functionality can be seen as “associated with” each other such that the desired functionality is achieved, irrespective of architectures or intermedial components. Likewise, any two components so associated can also be viewed as being “operably connected”, or “operably coupled”, to each other to achieve the desired functionality, and any two components capable of being so associated can also be viewed as being “operably couplable”, to each other to achieve the desired functionality. Specific examples of operably couplable include but are not limited to physically mateable and/or physically interacting components and/or wirelessly interactable and/or wirelessly interacting components and/or logically interacting and/or logically interactable components.

While particular aspects of the present subject matter described herein have been shown and described, it will be apparent to those skilled in the art that, based upon the teachings herein, changes and modifications may be made without departing from the subject matter described herein and its broader aspects and, therefore, the appended claims are to encompass within their scope all such changes and modifications as are within the true spirit and scope of the subject matter described herein. Furthermore, it is to be understood that the invention is defined by the appended claims.

It will be understood by those within the art that, in general, terms used herein, and especially in the appended claims (e.g., bodies of the appended claims) are generally intended as “open” terms (e.g., the term “including” should be interpreted as “including but not limited to,” the term “having” should be interpreted as “having at least,” the term “includes” should be interpreted as “includes but is not limited to,” etc.). It will be further understood by those within the art that if a specific number of an introduced claim recitation is intended, such an intent will be explicitly recited in the claim, and in the absence of such recitation no such intent is present. For example, as an aid to understanding, the following appended claims may contain usage of the introductory phrases “at least one” and “one or more” to introduce claim recitations. However, the use of such phrases should not be construed to imply that the introduction of a claim recitation by the indefinite articles “a” or “an” limits any particular claim containing such introduced claim recitation to inventions containing only one such recitation, even when the same claim includes the introductory phrases “one or more” or “at least one” and indefinite articles such as “a” or “an” (e.g., “a” and/or “an” should typically be interpreted to mean “at least one” or “one or more”); the same holds true for the use of definite articles used to introduce claim recitations.

In addition, even if a specific number of an introduced claim recitation is explicitly recited, those skilled in the art will recognize that such recitation should typically be interpreted to mean at least the recited number (e.g., the bare recitation of “two recitations,” without other modifiers, typically means at least two recitations, or two or more recitations). Furthermore, in those instances where a convention analogous to “at least one of A, B, and C, etc.” is used, in general such a construction is intended in the sense one having skill in the art would understand the convention (e.g., “a system having at least one of A, B, and C” would include but not be limited to systems that have A alone, B alone, C alone, A and B together, A and C together, B and C together, and/or A, B, and C together, etc.).

In those instances where a convention analogous to “at least one of A, B, or C, etc.” is used, in general such a construction is intended in the sense one having skill in the art would understand the convention (e.g., “a system having at least one of A, B, or C” would include but not be limited to systems that have A alone, B alone, C alone, A and B together, A and C together, B and C together, and/or A, B, and C together, etc.). It will be further understood by those within the art that virtually any disjunctive word and/or phrase presenting two or more alternative terms, whether in the description, claims, or drawings, should be understood to contemplate the possibilities of including one of the terms, either of the terms, or both terms. For example, the phrase “A or B” will be understood to include the possibilities of “A” or “B” or “A and B.”

II. Correlating Subjective User States with Objective Occurrences Associated with a User

In the following detailed description, reference is made to the accompanying drawings, which form a part hereof. In the drawings, similar symbols typically identify similar components, unless context dictates otherwise. The illustrative embodiments described in the detailed description, drawings, and claims are not meant to be limiting. Other embodiments may be utilized, and other changes may be made, without departing from the spirit or scope of the subject matter presented here.

A recent trend that is becoming increasingly popular in the computing/communication field is to electronically record one's feelings, thoughts, and other aspects of the person's everyday life onto an open diary. One place where such open diaries are maintained are at social networking sites commonly known as “blogs” where one or more users may report or post the latest news, their thoughts and opinions on various topics, and various aspects of the users' everyday life. The process of reporting or posting blog entries is commonly referred to as blogging. Other social networking sites may allow users to update their personal information via social network status reports in which a user may report or post for others to view the latest status or other aspects of the user.

A more recent development in social networking is the introduction and explosive growth of microblogs in which individuals or users (referred to as “microbloggers”) maintain open diaries at microblog websites (e.g., otherwise known as “twitter”) by continuously or semi-continuously posting microblog entries. A microblog entry (e.g., “tweet”) is typically a short text message that is usually not more than 140 characters long. The microblog entries posted by a microblogger may report on any aspect of the microblogger's daily life.

The various things that are typically posted though microblog entries may be categorized into one of at least two possible categories. The first category of things that may be reported through microblog entries are “objective occurrences” associated with the microblogger. Objective occurrences associated with the microblogger may be any characteristic, event, happening, or aspect associated with or is of interest to the microblogger that can be objectively reported by the microblogger, a third party, or by a device. These things would include, for example, food, medicine, or nutraceutical intake of the microblogger, certain physical characteristics of the microblogger such as blood sugar level or blood pressure that can be objectively measured, daily activities of the microblogger observable by others or by a device, the local weather, the stock market (which the microblogger may have an interest in), activities of others (e.g., spouse or boss) that may directly or indirectly affect the microblogger, and so forth.

A second category of things that may be reported or posted through microblogging entries include “subjective states” of the microblogger. Subjective states of a microblogger include any subjective state or status associated with the microblogger that can only be typically reported by the microblogger (e.g., generally cannot be reported by a third party or by a device). Such states including, for example, the mental state of the microblogger (e.g., “I am feeling happy”), particular physical states of the microblogger (e.g., “my ankle is sore” or “my ankle does not hurt anymore” or “my vision is blurry”), and overall state of the microblogger (e.g., “I'm good” or “I'm well”). Although microblogs are being used to provide a wealth of personal information, they have only been primarily limited to their use as a means for providing commentaries and for maintaining open diaries.

In accordance with various embodiments, methods, systems, and computer program products are provided for correlating subjective user state data (e.g., that indicate subjective user states of a user) with objective context data (e.g., that indicate objective occurrences associated with the user). In other words, to determine a causal relationship between objective occurrences (e.g., cause) and subjective user states (e.g., result) associated with a user (e.g., a blogger or microblogger). For example, determining that whenever a user eats a banana (e.g., objective occurrence) the user feels “good” (e.g., subjective user state). Note that an objective occurrence does not need to precede a corresponding subjective user state. For example, a person may become “gloomy” (e.g., subjective user state) whenever it is about to rain (e.g., objective occurrence).

As will be used herein a “subjective user state” is in reference to any state or status associated with a user (e.g., a blogger or microblogger) that only the user can typically indicate or describe. Such states include, for example, the subjective mental state of the user (e.g., user is feeling sad), a subjective physical state (e.g., physical characteristic) that only the user can typically indicate (e.g., a backache or an easing of a backache as opposed to blood pressure which can be reported by a blood pressure device and/or a third party), or the subjective overall state of the user (e.g., user is “good”). Examples of subjective mental states include, for example, happiness, sadness, depression, anger, frustration, elation, fear, alertness, sleepiness, and so forth. Examples of subjective physical states include, for example, the presence, easing, or absence of pain, blurry vision, hearing loss, upset stomach, physical exhaustion, and so forth. Subjective overall states may include any subjective user states that cannot be categorized as a subjective mental state or as a subjective physical state. Examples of overall states of a user that may be subjective user states include, for example, user being good, bad, exhausted, lack of rest, user wellness, and so forth.

In contrast, “objective context data” may include data that indicate objective occurrences associated with the user. An objective occurrence may be any physical characteristic, event, happenings, or aspects associated with or is of interest to a user that can be objectively reported by at least a third party or a sensor device. Note, however, that such objective context data does not have to be actually provided by a sensor device or by a third party, but instead, may be reported by the user himself or herself (e.g., via microblog entries). Examples of objectively reported occurrences that could by indicated by the objective context data include, for example, a user's food, medicine, or nutraceutical intake, the user's location at any given point in time, the user's exercise routine, user's blood pressure, the weather at user's location, activities associated with third parties, the stock market, and so forth.

The term “correlating” as will be used herein is in reference to a determination of one or more relationships between at least two variables. In the following exemplary embodiments, the first variable is subjective user state data that represents at least a first and a second subjective user state of a user and the second variable is objective context data that represents at least a first and a second objective occurrence associated with the user. Note that each of the at least first and second subjective user states represented by the subjective user state data may represent the same or similar type of subjective user state (e.g., user feels happy) but may be distinct subjective user states because they occurred at different points in time (e.g., user feels happy during a point in time and the user being happy again during another point in time). Similarly, each of the first and second objective occurrences represented by the objective context data may represent the same or similar type of objective occurrence (e.g., user eating a banana) but may be distinct objective occurrences because they occurred at different points in time (e.g., user ate a banana during a point in time and the user eating another banana during another point in time).

Various techniques may be employed for correlating the subjective user state data with the objective context data. For example, in some embodiments, correlating the objective context data with the subjective user state data may be accomplished by determining time sequential patterns or relationships between reported objective occurrences associated with a user and reported subjective user states of the user.

The following illustrative example is provided to describe how subjective user states and objective occurrences associated with a user may be correlated according to some embodiments. Suppose, for example, a user such as a microblogger reports that the user ate a banana on a Monday. The consumption of the banana, in this example, is a reported first objective occurrence associated with the user. The user then reports that 15 minutes after eating the banana, the user felt very happy. The reporting of the emotional state (e.g., felt very happy) is, in this example, a reported first subjective user state. On Tuesday, the user reports that the user ate another banana (e.g., a second objective occurrence associated with the user). The user then reports that 15 minutes after eating the second banana, the user felt somewhat happy (e.g., a second subjective user state). For purposes of this example, the reporting of the consumption of the bananas may be in the form of objective context data and the reporting of the user feeling very or somewhat happy may be in the form of subjective user state data. The reported information may then be examined from different perspectives in order to determine whether there is a correlation (e.g., relationship) between the subjective user state data indicating the subjective user states (e.g., happiness of the user) and the objective context data indicating the objective occurrences associated with the user (e.g., eating bananas).

Several approaches may be employed in various alternative implementations in order to determine whether there is correlation (e.g., a relationship) between the subjective user state data and the objective context data. For example, a determination may be made as to whether there is co-occurrence, temporal sequencing, temporal proximity, and so forth, between the subjective user states (e.g., as provided by the subjective user state data) and the objective occurrences (e.g., as provided by the objective context data) associated with the user. One or more factors may be relevant in the determination of whether there is correlation between the subjective user state data and the objective context data.

One factor that may be examined in order to determine whether a relationship exists between the subjective user state data (e.g., happiness of the user) and the objective context data (e.g., consumption of bananas) is whether the first and second objective occurrences (e.g., consuming a banana) of the user are the same or similar (e.g., extent of similarity or difference). In this case, the first and second objective occurrences are the same. Note that consumption of the bananas could have been further defined. For example, the quantity or the type of bananas consumed could have been specified. If the quantity or the type of bananas consumed were not the same, then this could negatively impact the correlation (e.g., determination of a relationship) of the subjective user state data (e.g., happiness of the user) with the objective context data (e.g., eating bananas).

Another relevant factor that could be examined is whether the first and second subjective user states of the user are the same or similar (e.g., extent of similarity or difference). In this case, the first subjective user state (e.g., felt very happy) and second subjective user states (e.g., felt somewhat happy) are not the same but are similar. In this case, the comparison of the two subjective user states indicates that the two subjective user states, although not the same, are similar. This may result ultimately in a determination of a weaker correlation between the subjective user state data and the objective context data.

A third relevant factor that may be examined is whether the time difference between the first subjective user state and the first objective occurrence associated with the user (e.g., 15 minutes) and the time difference between the second subjective user state and the second objective occurrence associated with the user (e.g., 15 minutes) are the same or similar. In this case, the time difference between the first subjective user state and the first objective occurrence associated with the user (e.g., 15 minutes) and the time difference between the second subjective user state and the second objective occurrence associated with the user (e.g., 15 minutes) are indeed the same. As a result, this may indicate a relatively strong correlation between the subjective user state data (e.g., happiness of the user) and the objective context data (e.g., eating of bananas by the user). This operation is a relatively simple way of determining time sequential patterns. Note that if the time difference between the first subjective user state and the first objective occurrence associated with the user and the time difference between the second subjective user state and the second objective occurrence associated with the user (e.g., 15 minutes) were not the same or not similar, a weaker correlation or no correlation between the subjective user state data (e.g., happiness of the user) and the objective context data (e.g., eating of bananas by the user) may be concluded. Further, if the time differences were large (e.g., there was a four hour gap between the reporting of a consumption of a banana and the feeling of happiness), then this may indicate a weaker correlation between the subjective user state data (e.g., happiness of the user) and the objective context data (e.g., eating of bananas by the user).

The review of the subjective user state data and the objective context data from these perspectives may facilitate in determining whether there is a correlation between such data. That is, by examining such data from the various perspectives as described above, a determination may be made as to whether there is a sequential relationship between subjective user states (e.g., happiness of the user) and objective occurrences (e.g., consumption of bananas) associated with the user. Of course, those skilled in the art will recognize that the correlation of subjective user state data with objective context data may be made with greater confidence if more data points are obtained. For instance, in the above example, a stronger relationship may be determined between the subjective user state data (e.g., happiness of the user) and the objective context data (e.g., consumption of bananas) if additional data points with respect to the subjective user state data (e.g., a third subjective user state, a fourth subjective user state, and so forth) and the objective context data (e.g., a third objective occurrence, a fourth objective occurrence, and so forth) were obtained and analyzed.

In alternative embodiments, other techniques may be employed in order to correlate subjective user state data with objective context data. For example, one approach is to determine whether a subjective user state repeatedly occurs before, after, or at least partially concurrently with an objective occurrence. For instance, a determination may be made as to whether a user repeatedly has a stomach ache (e.g., subjective user state) each time after eating a banana (e.g., objective occurrence). In another example, a determination may be made as to whether a user repeatedly feels gloomy (e.g., subjective user state) before each time it begins to rain (e.g., objective occurrence). In still another example, a determination may be made as to whether a user repeatedly feels happy (e.g., subjective user state) each time his boss leaves town (e.g., objective occurrence).

FIGS. 1-1a and 1-1b illustrate an example environment in accordance with various embodiments. In the illustrated environment, an exemplary system 1-100 may include at least a computing device 1-10 (see FIG. 1-1b) that may be employed in order to, among other things, collect subjective user state data 1-60 and objective context data 1-70* that are associated with a user 1-20*, and to correlate the subjective user state data 1-60 with the objective context data 1-70*. Note that in the following, “*” indicates a wildcard. Thus, user 1-20* may indicate a user 1-20a or a user 1-20b of FIGS. 1-1a and 1-1b.

In some embodiments, the computing device 1-10 may be a network server in which case the computing device 1-10 may communicate with a user 1-20a via a mobile device 1-30 and through a wireless and/or wired network 1-40. Note that a network server as described herein may be in reference to a network server located at a single network site or located across multiple network sites or a conglomeration of servers located at multiple network sites. The mobile device 1-30 may be a variety of computing/communication devices including, for example, a cellular phone, a personal digital assistant (PDA), a laptop, or some other type of mobile computing/communication device. In alternative embodiments, the computing device 1-10 may be a local computing device that communicates directly with a user 1-20b. For these embodiments, the computing device 1-10 may be any type of handheld device such as a cellular telephone or a PDA, or other types of computing/communication devices such as a laptop computer, a desktop computer, and so forth. In certain embodiments, the computing device 1-10 may be a peer-to-peer network component device. In some embodiments, the local device 1-30 may operate via web 2.0 construct.

In embodiments where the computing device 1-10 is a server, the computing device 1-10 may indirectly obtain the subjective user state data 1-60 from a user 1-20a via the mobile device 1-30. In alternative embodiments in which the computing device 1-10 is a local device, the subjective user state data 1-60 may be directly obtained from a user 1-20b. As will be further described, the computing device 1-10 may acquire the objective context data 1-70* from one or more different sources.

For ease of illustration and explanation, the following systems and operations to be described herein will be generally described in the context of the computing device 1-10 being a network server. However, those skilled in the art will recognize that these systems and operations may also be implemented when the computing device 1-10 is a local device communicating directly with a user 1-20b.

Assuming that the computing device 1-10 is a server, the computing device 1-10 may be configured to acquire subjective user state data 1-60 including at least a first subjective user state 1-60a and a second subjective user state 1-60b via the mobile device 1-30 and through wireless and/or wired networks 1-40. In some embodiments, the first subjective user state 1-60a and the second subjective user state 1-60b may be in the form of blog entries, such as microblog entries, or embodied in some other form of electronic messages. The first subjective user state 1-60a and the second subjective user state 1-60b may, in some instances, indicate the same, similar, or completely different subjective user state. Examples of subjective user states indicated by the first subjective user state 1-60a and the second subjective user state 1-60b include, for example, a mental state of the user 1-20a (e.g., user 1-20a is sad or angry), a physical state of the user 1-20a (e.g., physical or physiological characteristic of the user 1-20a such as the presence or absence of a stomach ache or headache), an overall state of the user 1-20a (e.g., user is “well”), or other subjective user states that only the user 1-20a can typically indicate.

The computing device 1-10 may be further configured to acquire objective context data 1-70* from one or more sources. For instance, objective context data 1-70a may be acquired, in some instances, from one or more third parties 1-50 (e.g., other users, a health care provider, a hospital, a place of employment, a content provider, and so forth). In some alternative situations, objective context data 1-70b may be acquired from one or more sensors 1-35 (e.g., blood pressure device or glucometer) sensing, for example, one or more physical characteristics of the user 1-20a. Note that the one or more sensors 1-35 may be other types of sensors for measuring and providing to the computing device 1-10 other subjective occurrences associated with user 1-20a. For example, in some cases, sensors 1-35 may include a global positioning system (GPS) device for determining the location of the user 1-20a or a physical activity sensor for measuring physical activities of the user 1-20a. Examples of a physical activity sensor include, for example, a pedometer for measuring physical activities of the user 1-20a. In some implementations, the one or more sensors 1-35 may include one or more physiological sensor devices for measuring physiological characteristics of the user 1-20a. Examples of physiological sensor devices include, for example, a blood pressure monitor, a heart rate monitor, a glucometer, and so forth. In some implementations, the one or more sensors 1-35 may include one or more image capturing devices such as a video or digital camera.

In still other situations, objective context data 1-70c may be acquired from the user 1-20a via the mobile device 1-30. For these situations, the objective context data 1-70c may indicate, for example, activities (e.g., exercise or food or medicine intake) performed by the user 1-20a, certain physical characteristics (e.g., blood pressure or location) associated with the user 1-20a, or other aspects associated with the user 1-20a that the user 1-20a can report objectively. In still other alternative cases, objective context data 1-70d may be acquired from a memory 1-140.

In various embodiments, the context data 1-70* acquired by the computing device 1-10 may include at least a first context data indicative of a first objective occurrence associated with the user 1-20a and a second context data indicative of a second objective occurrence associated with the user 1-20a. In some implementations, the first and second context data may be acquired in the form of blog entries (e.g., microblog entries) or in other forms of electronic messages.

The computing device 1-10 may be further configured to correlate the acquired subjective user data 1-60 with the acquired context data 1-70*. By correlating the acquired subjective user data 1-60 with the acquired context data 1-70*, a determination may be made as to whether there is a relationship between the acquired subjective user data 1-60 with the acquired context data 1-70*. In some embodiments, and as will be further indicated in the operations and processes to be described herein, the computing device 1-10 may be further configured to present one or more the results of correlation. In various embodiments, the one or more correlation results 1-80 may be presented to the user 1-20a and/or to one or more third parties 1-50. The one or more third parties 1-50 may be other users such as other microbloggers, a health care provider, advertisers, and/or content providers.

As illustrated in FIG. 1-1b, computing device 1-10 may include one or more components or sub-modules. For instance, in various implementations, computing device 1-10 may include a subjective user state data acquisition module 1-102, an objective context data acquisition module 1-104, a correlation module 1-106, a presentation module 1-108, a network interface 1-120, a user interface 1-122, a time stamp module 1-124, one or more applications 1-126, and/or memory 1-140. The functional roles of these components/modules will be described in the processes and operations to be described herein.

FIG. 1-2a illustrates particular implementations of the subjective user state data acquisition module 1-102 of the computing device 1-10 of FIG. 1-1b. In brief, the subjective user state data acquisition module 1-102 may be designed to, among other things, acquire subjective user state data 1-60 including at least a first subjective user state 1-60a and a second subjective user state 1-60b. As further illustrated, the subjective user state data acquisition module 1-102 in various implementations may include a reception module 1-202 for receiving the subjective user state data 1-60 from a user 1-20a via the network interface 1-120 or for receiving the subjective user state data 1-60 directly from a user 1-20b (e.g., in the case where the computing device 1-10 is a local device) via the user interface 1-122.

In some implementations, the reception module 1-202 may further include a text entry reception module 1-204 for receiving subjective user state data that was obtained based, at least in part, on a text entry provided by a user 1-20*. For example, in some implementations the text entry reception module 1-204 may be designed to receive subjective user state data 1-60 that was obtained based, at least in part, on a text entry (e.g., a text microblog entry) provided by a user 1-20a using a mobile device 1-30. In an alternative implementation or the same implementation, the reception module 1-202 may include an audio entry reception module 1-205 for receiving subjective user state data that was obtained based, at least in part, on an audio entry provided by a user 1-20*. For example, in some implementations the audio entry reception module 1-205 may be designed to receive subjective user state data 1-60 that was obtained based, at least in part, on an audio entry (e.g., an audio microblog entry) provided by a user 1-20a using a mobile device 1-30.

In some implementations, the subjective user state data acquisition module 1-102 may include a solicitation module 1-206 for soliciting from a user 1-20* a subjective user state. For example, the solicitation module 1-206, in some implementations, may be designed to solicit from a user 1-20b, via a user interface 1-122 (e.g., in the case where the computing device 1-10 is a local device), a subjective user state of the user 1-20b (e.g., whether the user 1-20b is feeling very good, good, bad, or very bad). The solicitation module 1-206 may further include a transmission module 1-207 for transmitting to a user 1-20a a request requesting a subjective user state 1-60*. For example, the transmission module 1-207 may be designed to transmit to a user 1-20a, via a network interface 1-122, a request requesting a subjective user state 1-60*. The solicitation module 1-206 may be used in some circumstances in order to prompt the user 1-20* to provide useful data. For instance, if the user 1-20* has reported a first subjective user state 1-60a following a first objective occurrence, then the solicitation module 1-206 may solicit from the user 1-20* a second subjective user state 1-60b following the happening of the second objective occurrence.

Referring now to FIG. 1-2b illustrating particular implementations of the objective context data acquisition module 1-104 of the computing device 1-10 of FIG. 1-lb. In various implementations, the objective context data acquisition module 1-104 may be configured to acquire (e.g., either receive, solicit, or retrieve from a user 1-20*, a third party 1-50, a sensor 1-35, and/or a memory 1-140) objective context data 1-70* including at least a first context data indicative of a first objective occurrence associated with a user 1-20* and a second context data indicative of a second objective occurrence associated with the user 1-20*. In some implementations, the objective context data acquisition module 1-104 may include an objective context data reception module 1-208 that is configured to receive objective context data 1-70*. For example, the objective context data reception module 1-208 may be designed to receive, via a user interface 1-122 or a network interface 1-120, context data from a user 1-20*, from a third party 1-50, and/or from a sensor 1-35.

Turning now to FIG. 1-2c illustrating particular implementations of the correlation module 1-106 of the computing device 1-10 of FIG. 1-1b. The correlation module 1-106 may be configured to, among other things, correlate subjective user state data 1-60 with objective context data 1-70*. In some implementations, the correlation module 1-106 may include a subjective user state difference determination module 1-210 for determining an extent of difference between a first subjective user state 1-60a and a second subjective user state 1-60b associated with a user 1-20*. In the same or different implementations, the correlation module 1-106 may include a objective occurrence difference determination module 1-212 for determining an extent of difference between at least a first objective occurrence and a second objective occurrence associated with a user 1-20*.

In the same or different implementations, the correlation module 1-106 may include a subjective user state and objective occurrence time difference determination module 1-214. As will be further described below, the subjective user state and objective occurrence time difference determination module 1-214 may be configured to determine at least an extent of time difference between a subjective user state associated with a user 1-20* and an objective occurrence associated with the user 1-20*. In the same or different implementations, the correlation module 1-106 may include a comparison module 1-216 for comparing an extent of time difference between a first subjective user state and a first objective occurrence associated with a user 1-20* with the extent of time difference between a second subjective user state and a second objective occurrence associated with the user 1-20*.

In the same or different implementations, the correlation module 1-106 may include a strength of correlation determination module 1-218 for determining a strength of correlation between subjective user state data and objective context data associated with a user 1-20*. In some implementations, the strength of correlation may be determined based, at least in part, on results provided by the objective occurrence difference determination module 1-210, the objective occurrence difference determination module 1-212, the subjective user state and objective occurrence time difference determination module 1-214 and/or the comparison module 1-216. In some implementations, and as will be further described herein, the correlation module 1-106 may include a determination module 1-219 for determining whether a subjective user state occurred before, after, or at least partially concurrently with an objective occurrence associated with a user 1-20*.

FIG. 1-2d illustrates particular implementations of the presentation module 1-108 of the computing device 1-10 of FIG. 1-1b. In various implementations, the presentation module 1-108 may be configured to present one or more results of the correlation performed by the correlation module 1-106. For example, in some implementations this may entail the presentation module 1-108 presenting to the user 1-20* an indication of a sequential relationship between a subjective user state and an objective occurrence associated with the user 1-20* (e.g., “whenever you eat a banana, you have a stomachache). Other types of results may also be presented in other alternative implementations as will be further described herein.

In various implementations, the presentation module 1-108 may include a transmission module 1-220 for transmitting one or more results of the correlation performed by the correlation module 1-106. For example, in the case where the computing device 1-10 is a server, the transmission module 1-220 may be configured to transmit to the user 1-20a or a third party 1-50 the one or more results of the correlation performed by the correlation module 1-106 via a network interface 1-120.

In some alternative implementations, the presentation module may include a display module 1-222 for displaying the one or more results of the correlation performed by the correlation module 1-106. For example, in the case where the computing device 1-10 is a local device, the display module 1-222 may be configured to display to the user 1-20b the one or more results of the correlation performed by the correlation module 1-106 via a user interface 1-122.

Referring back to FIG. 1-1b, and as briefly described earlier, in some implementations, the computing device 1-10 may include a time stamp module 1-124. For these implementations, the time stamp module 1-124 may be configured to provide time stamps for objective occurrences and/or subjective user states associated with a user 1-20*. For example, if the computing device 1-10 is a local device that communicates directly with a user 1-20a, then the time stamp module 1-124 may generate a first time stamp for the first subjective user state 1-60a and a second time stamp for the second subjective user state 1-60b. Note that the time stamps provided by the time stamp module 1-124 may be associated with subjective user states and/or objective occurrences rather than being associated with subjective user state data 1-60 and/or objective context data 1-70*. That is, the times in which the subjective user states and/or the objective occurrences occurred may be more relevant than when these events were actually reported (e.g., reported via microblog entries).

In various embodiments, the computing device 1-10 may include a network interface 1-120 that may facilitate in communicating with a user 1-20a and/or one or more third parties 1-50. For example, in embodiments whereby the computing device 1-10 is a server, the computing device 1-10 may include a network interface 1-120 that may be configured to receive from the user 1-20a subjective user state data 1-60. In some embodiments, objective context data 1-70a, 1-70b, or 1-70c may be received through the communication interface 1-120. Examples of a network interface 1-120 includes, for example, a network interface card (NIC).

In various embodiments, the computing device 1-10 may include a user interface 1-122 to communicate directly with a user 1-20b. For example, in embodiments in which the computing device 1-10 is a local device, the user interface 1-122 may be configured to directly receive from the user 1-20b subjective user state data 1-60. The user interface 1-122 may include, for example, one or more of a display monitor, a touch screen, a key board, a mouse, an audio system, and/or other user interface devices.

FIG. 1-2e illustrates particular implementations of the one or more applications 1-126 of FIG. 1-1b. For these implementations, the one or more applications 1-126 may include, for example, communication applications such as a text messaging application and/or an audio messaging application including a voice recognition system application. In some implementations, the one or more applications 1-126 may include a web 2.0 application 1-230 to facilitate communication via, for example, the World Wide Web.

FIG. 1-3 illustrates an operational flow 1-300 representing example operations related to acquisition and correlation of subjective user state data and objective context data in accordance with various embodiments. In some embodiments, the operational flow 1-300 may be executed by, for example, the computing device 1-10 of FIG. 1-1b.

In FIG. 1-3 and in the following figures that include various examples of operational flows, discussions and explanations may be provided with respect to the above-described exemplary environment of FIGS. 1-1a and 1-1b, and/or with respect to other examples (e.g., as provided in FIGS. 1-2a to 1-2e) and contexts. However, it should be understood that the operational flows may be executed in a number of other environments and contexts, and/or in modified versions of FIGS. 1-1a, 1-1b, and 1-2a to 1-2e. Also, although the various operational flows are presented in the sequence(s) illustrated, it should be understood that the various operations may be performed in other orders than those which are illustrated, or may be performed concurrently.

Further, in FIG. 1-3 and in following figures, various operations may be depicted in a box-within-a-box manner. Such depictions may indicate that an operation in an internal box may comprise an optional example embodiment of the operational step illustrated in one or more external boxes. However, it should be understood that internal box operations may be viewed as independent operations separate from any associated external boxes and may be performed in any sequence with respect to all other illustrated operations, or may be performed concurrently.

In any event, after a start operation, the operational flow 1-300 may move to a subjective user state data acquisition operation 1-302 for acquiring subjective user state data including at least a first subjective user state and a second subjective user state as performed by, for example, the computing device 1-10 of FIG. 1-1b. For instance, the subjective user state data acquisition module 1-102 of the computing device 1-10 acquiring subjective user state data 1-60 (e.g., in the form of text or audio microblog entries) including at least a first subjective user state 1-60a (e.g., the user 1-20* is feeling sad) and a second subjective user state 1-60b (e.g., the user 1-20* is again feeling sad).

Operational flow 1-300 further includes an objective context data acquisition operation 1-304 for acquiring objective context data including at least a first context data indicative of a first objective occurrence associated with a user and a second context data indicative of a second objective occurrence associated with the user as performed by, for example, the computing device 1-10. For instance, the objective context data acquisition module 1-104 of the computing device 1-10 acquiring via a wireless and/or wired network 1-40 objective context data 1-70* (e.g., as provided by a third party source or by the user 1-20a) including at least a first context data 1-70* indicative of a first occurrence (e.g., cloudy weather) associated with a user 1-20* and a second context data 1-70* indicative of a second occurrence (e.g., cloudy weather) associated with the user 1-20*. Note that, and as those skilled in the art will recognize, the subjective user state data acquisition operation 1-302 does not have to be performed prior to the objective context data acquisition operation 1-304 and may be performed subsequent to the performance of the objective context data acquisition operation 1-304 or may be performed concurrently with the objective context data acquisition operation 1-304.

Finally, a correlation operation 1-306 for correlating the subjective user state data with the objective context data may be performed by, for example, the computing device 1-10. For instance, the correlation module 1-106 of the computing device 1-10 correlating the subjective user state data 1-60 with the objective context data 1-70* by determining a sequential time relationship between the subjective user state data 1-60 and the objective context data 1-70* (e.g., user 1-20* will be sad whenever it is cloudy).

In various implementations, the subjective user state data acquisition operation 1-302 may include one or more additional operations as illustrated in FIGS. 1-4a, 1-4b, 1-4c, and 1-4d. For example, in some implementations the subjective user state data acquisition operation 1-302 may include a reception operation 1-402 for receiving at least a first subjective user state as depicted in FIG. 1-4a to 1-4c. For instance, the reception module 1-202 (see FIG. 1-2a) of the computing device 1-10 receiving (e.g., via the network interface 1-120 or via the user interface 1-122) at least a first subjective user state 1-60a (e.g., indicating a first subjective mental, physical, or overall state of a user 1-20*).

In various alternative implementations, the reception operation 1-402 may further include one or more additional operations. For example, in some implementations, reception operation 1-402 may include an operation 1-404 for receiving a first subjective user state from at least one of a wireless network or a wired network as depicted in FIG. 1-4a. For instance, the reception module 1-202 (see FIG. 1-2a) of the computing device 1-10 receiving (e.g., receiving via the network interface 1-120) a first subjective user state 1-60a (e.g., a first subjective overall state of the user 1-20a indicating, for example, user wellness) from at least one of a wireless network or a wired network 1-40.

In various implementations, the reception operation 1-402 may include an operation 1-406 for receiving a first subjective user state via an electronic message generated by the user as illustrated in FIG. 1-4a. For instance, the reception module 1-202 of the computing device 1-10 receiving (e.g., via a network interface 1-120) a first subjective user state 1-60a (e.g., a first subjective mental state of the user 1-20a indicating, for example, user anger) via an electronic message (e.g., text or audio message) generated by the user 1-20a.

In some implementations, the reception operation 1-402 may include an operation 1-408 for receiving a first subjective user state via a first blog entry generated by the user as depicted in FIG. 1-4a. For instance, the reception module 1-202 of the computing device 1-10 receiving (e.g., via a network interface 1-120) a first subjective user state 1-60a (e.g., a first subjective physical state of the user 1-20a indicating, for example, the presence or absence of pain) via a first blog entry generated by the user 1-20a.

In some implementations, the reception operation 1-402 may include an operation 1-409 for receiving a first subjective user state via a status report generated by the user as depicted in FIG. 1-4a. For instance, the reception module 1-202 of the computing device 1-10 receiving (e.g., through a network interface 1-120) a first subjective user state via a status report (e.g., a social network status report, a collaborative environment status report, a shared browser status report, or some other status report) generated by the user 1-20a.

In various implementations, the reception operation 1-402 may include an operation 1-410 for receiving a second subjective user state via an electronic message generated by the user as depicted in FIG. 1-4a. For instance, the reception module 1-202 of the computing device 1-10 receiving (e.g., via a network interface 1-120) a second subjective user state 1-60b (e.g., a second subjective mental state of the user 1-20a indicating, for example, user anger) via an electronic message (e.g., text or audio message) generated by the user 1-20a.

In some implementations, the reception operation 1-402 may further include an operation 1-412 for receiving a second subjective user state via a second blog entry generated by the user as depicted in FIG. 1-4a. For instance, the reception module 1-202 of the computing device 1-10 receiving (e.g., via a network interface 1-120) a second subjective user state (e.g., a second subjective physical state of the user 1-20a indicating, for example, the presence or absence of pain) via a second blog entry generated by the user 1-20a.

In some implementations, the reception operation 1-402 may further include an operation 1-413 for receiving a second subjective user state via a status report generated by the user as depicted in FIG. 1-4a. For instance, the reception module 1-202 of the computing device 1-10 receiving (e.g., via a network interface 1-120) a second subjective user state via a status report (e.g., a social network status report, a collaborative environment status report, a shared browser status report, or some other status report) generated by the user 1-20a.

In various implementations, the reception operation 1-402 may include an operation 1-414 for receiving a first subjective user state that was obtained based, at least in part, on data provided by the user, the provided data indicating the first subjective user state associated with the user as depicted in FIG. 1-4a. For instance, the reception module 1-202 of the computing device 1-10 receiving (e.g., via the network interface 1-120 or via the user interface 1-122) a first subjective user state (e.g., a first subjective mental, physical, or overall state of the user 1-20*) that was obtained based, at least in part, on data provided by the user 1-20*, the provided data indicating the first subjective user state associated with the user 1-20*.

In some implementations, operation 1-414 may further include an operation 1-416 for receiving a first subjective user state that was obtained based, at least in part, on a text entry provided by the user as depicted in FIG. 1-4a. For instance, the text entry reception module 1-204 (see FIG. 1-2a) of the computing device 1-10 receiving (e.g., via the network interface 1-120 or the user interface 1-122) a first subjective user state 1-60a (e.g., a subjective mental, physical, or overall state of the user 1-20*) that was obtained based, at least in part, on a text entry provided by the user 1-20*.

In some implementations, operation 1-414 may further include an operation 1-418 for receiving a first subjective user state that was obtained based, at least in part, on an audio entry provided by the user as depicted in FIG. 1-4a. For instance, the audio entry reception module 1-206 (see FIG. 1-2a) of the computing device 1-10 receiving (e.g., via the network interface 1-120 or the user interface 1-122) a first subjective user state 1-60a (e.g., a subjective mental, physical, or overall state of the user 1-20*) that was obtained based, at least in part, on an audio entry provided by the user 1-20*.

In some implementations, operation 1-414 may further include an operation 1-419 for receiving a first subjective user state that was obtained based, at least in part, on an image entry provided by the user as depicted in FIG. 1-4a. For instance, the reception module 1-202 of the computing device 1-10 receiving (e.g., via the network interface 1-120 or via the user interface 1-122) a first subjective user state 1-60a that was obtained based, at least in part, on an image entry (e.g., to capture a gesture such a “thumbs up” gesture or to capture a facial expression such as a grimace made by the user 1-20*) provided by the user 1-20*.

In various implementations, the reception operation 1-402 may include an operation 1-420 for receiving a first subjective user state indicating a subjective mental state of the user as depicted in FIG. 1-4b. For instance, the reception module 1-202 of the computing device 1-10 receiving (e.g., via the network interface 1-120 or via the user interface 1-122) a first subjective user state 1-60a indicating a subjective mental state (e.g., feeling happy or drowsy) of the user 1-20*.

In some implementations, operation 1-420 may further include an operation 1-422 for receiving a first subjective user state indicating a level of the subjective mental state of the user as depicted in FIG. 1-4a. For instance, the reception module 1-202 of the computing device 1-10 receiving (e.g., via the network interface 1-120 or via the user interface 1-122) a first subjective user state 1-60a indicating a level of the subjective mental state (e.g., feeling extremely happy or very drowsy) of the user 1-20*.

The reception operation 1-402 in various implementations may include an operation 1-424 for receiving a first subjective user state indicating a subjective physical state of the user as depicted in FIG. 1-4b. For instance, the reception module 1-202 of the computing device 1-10 receiving (e.g., via the network interface 1-120 or via the user interface 1-122) a first subjective user state 1-60a (e.g., as provided by user 1-20* via a text or audio entry) indicating a subjective physical state (e.g., absence or presence of a headache or sore back) of the user 1-20*.

In some implementations, operation 1-424 may further include an operation 1-426 for receiving a first subjective user state indicating a level of the subjective physical state of the user as depicted in FIG. 1-4b. For instance, the reception module 1-202 of the computing device 1-10 receiving (e.g., via the network interface 1-120 or via the user interface 1-122) a first subjective user state 1-60a indicating a level of the subjective physical state (e.g., absence or presence of a very bad headache or a very sore back) of the user 1-20*.

In various implementations, the reception operation 1-402 may include an operation 1-428 for receiving a first subjective user state indicating a subjective overall state of the user as depicted in FIG. 1-4b. For instance, the reception module 1-202 of the computing device 1-10 receiving (e.g., via the network interface 1-120 or via the user interface 1-122) a first subjective user state 1-60a indicating a subjective overall state (e.g., user 1-20* is “well”) of the user 1-20*.

In some implementations, operation 1-428 may further include an operation 1-430 for receiving a first subjective user state indicating a level of the subjective overall state of the user as depicted in FIG. 1-4b. For instance, the reception module 1-202 of the computing device 1-10 receiving (e.g., via the network interface 1-120 or via the user interface 1-122) a first subjective user state 1-60a indicating a level of the subjective overall state (e.g., user is “very well”) of the user 1-20*.

In certain implementations, the reception operation 1-402 may include an operation 1-432 for receiving a second subjective user state that was obtained based, at least in part, on data provided by the user, the provided data indicating the second subjective user state associated with the user as depicted in FIG. 1-4b. For instance, the reception module 1-202 of the computing device 1-10 receiving (e.g., via the network interface 1-120 or via the user interface 1-122) a second subjective user state 1-60b (e.g., a second subjective mental, physical, or overall state of the user 1-20*) that was obtained based, at least in part, on data provided by the user 1-20*, the provided data indicating the second subjective user state associated with the user 1-20*.

In some implementations, operation 1-432 may further include an operation 1-434 for receiving a second subjective user state that was obtained based, at least in part, on a text entry provided by the user as depicted in FIG. 1-4b. For instance, the text entry reception module 1-204 (see FIG. 1-2a) of the computing device 1-10 receiving (e.g., via the network interface 1-120 or the user interface 1-122) a second subjective user state 1-60b (e.g., a subjective mental, physical, or overall state of the user 1-20*) that was obtained based, at least in part, on a text entry provided by the user 1-20*.

In some implementations, operation 1-432 may further include an operation 1-436 for receiving a second subjective user state that was obtained based, at least in part, on an audio entry provided by the user as depicted in FIG. 1-4b. For instance, the audio entry reception module 1-206 (see FIG. 1-2a) of the computing device 1-10 receiving (e.g., via the network interface 1-120 or the user interface 1-122) a second subjective user state 1-60b (e.g., a subjective mental, physical, or overall state of the user 1-20*) that was obtained based, at least in part, on an audio entry provided by the user 1-20*.

In some implementations, operation 1-432 may further include an operation 1-437 for receiving a second subjective user state that was obtained based, at least in part, on an image entry provided by the user. For instance, the reception module 1-202 of the computing device 1-10 receiving (e.g., via the network interface 1-120 or via the user interface 1-122) a second subjective user state 1-60b that was obtained based, at least in part, on an image entry (e.g., to capture a gesture such a “thumbs down” gesture or to capture a facial expression such as a smile made by the user 1-20*) provided by the user 1-20*.

In various implementations, the reception operation 1-402 may include an operation 1-438 for receiving a second subjective user state indicating a subjective mental state of the user as depicted in FIG. 1-4b. For instance, the reception module 1-202 of the computing device 1-10 receiving (e.g., via the network interface 1-120 or via the user interface 1-122) a second subjective user state 1-60b indicating a subjective mental state (e.g., feeling sad or alert) of the user 1-20*.

In some implementations, operation 1-438 may further include an operation 1-440 for receiving a second subjective user state indicating a level of the subjective mental state of the user as depicted in FIG. 1-4b. For instance, the reception module 1-202 of the computing device 1-10 receiving (e.g., via the network interface 1-120 or via the user interface 1-122) a second subjective user state 1-60b indicating a level of the subjective mental state (e.g., feeling extremely sad or extremely alert) of the user 1-20*.

The reception operation 1-402, in various implementations, may include an operation 1-442 for receiving a second subjective user state indicating a subjective physical state of the user as depicted in FIG. 1-4c. For instance, the reception module 1-202 of the computing device 1-10 receiving (e.g., via the network interface 1-120 or via the user interface 1-122) a second subjective user state 1-60b indicating a subjective physical state (e.g., having blurry vision or being nauseous) of the user 1-20*.

In some implementations, operation 1-442 may further include an operation 1-444 for receiving a second subjective user state indicating a level of the subjective physical state of the user as depicted in FIG. 1-4c. For instance, the reception module 1-202 of the computing device 1-10 receiving (e.g., via the network interface 1-120 or via the user interface 1-122) a second subjective user state 1-60b indicating a level of the subjective physical state (e.g., having slightly blurry vision or being slightly nauseous) of the user 1-20*.

In various implementations, the reception operation 1-402 may include an operation 1-446 for receiving a second subjective user state indicating a subjective overall state of the user as depicted in FIG. 1-4c. For instance, the reception module 1-202 of the computing device 1-10 receiving (e.g., via the network interface 1-120 or via the user interface 1-122) a second subjective user state 1-60b indicating a subjective overall state (e.g., user 1-20* is “exhausted”) of the user 1-20*.

In some implementations, operation 1-446 may further include an operation 1-448 for receiving a second subjective user state indicating a level of the subjective overall state of the user as depicted in FIG. 1-4c. For instance, the reception module 1-202 of the computing device 1-10 receiving (e.g., via the network interface 1-120 or via the user interface 1-122) a second subjective user state 1-60b indicating a level of the subjective overall state (e.g., user 1-20* is “extremely exhausted”) of the user 1-20*.

In various implementations, the subjective user state data acquisition operation 1-302 may include an operation 1-450 for acquiring a first time stamp associated with the first subjective user state and a second time stamp associated with the second subjective user state as depicted in FIG. 1-4c. For instance, the subjective user state data acquisition module 1-102 of the computing device 1-10 acquiring (e.g., receiving via the network interface 1-120 or generating via time stamp module 1-124) a first time stamp associated with the first subjective user state 1-60a and a second time stamp associated with the second subjective user state 1-60b.

In various implementations, the subjective user state data acquisition operation 1-302 may include an operation 1-452 for acquiring subjective user state data including at least a first subjective user state and a second subjective user state that is equivalent to the first subjective user state as depicted in FIG. 1-4d. For instance, the subjective user state data acquisition module 1-102 acquiring (e.g., via network interface 1-120 or via user interface 1-122) subjective user state data 1-60 including at least a first subjective user state (e.g., user 1-20* feels sleepy) and a second subjective user state (e.g., user 1-20* feels sleepy) that is equivalent to the first subjective user state 1-60a.

In various implementations, the subjective user state data acquisition operation 1-302 may include an operation 1-454 for acquiring subjective user state data including at least a first subjective user state and a second subjective user state that is proximately equivalent to the first subjective user state as depicted in FIG. 1-4d. For instance, the subjective user state data acquisition module 1-102 acquiring (e.g., via network interface 1-120 or via user interface 1-122) subjective user state data 1-60 including at least a first subjective user state 1-60a (e.g., user 1-20* feels angry) and a second subjective user state 1-60b (e.g., user 1-20* feels extremely angry) that is proximately equivalent to the first subjective user state 1-60a.

In various implementations, the subjective user state data acquisition operation 1-302 may include an operation 1-455 for soliciting from the user at least one of the first subjective user state or the second subjective user state as depicted in FIG. 1-4d. For instance, the solicitation module 1-206 (see FIG. 1-2a) of the computing device 1-10 soliciting from the user 1-20* (e.g., via network interface 1-120 or via user interface 1-122) at least one of the first subjective user state 1-60a (e.g., mental, physical, or overall user state) or the second subjective user state 1-60b (e.g., mental, physical, or overall user state).

In some implementations, operation 1-455 may further include an operation 1-456 for transmitting to the user a request for a subjective user state as depicted in FIG. 1-4d. For instance, the transmission module 1-207 (see FIG. 1-2a) of the computing device 1-10 transmitting (e.g., via the network interface 1-120) to the user 1-20a a request for a subjective user state. In some cases, the request may provide to the user 1-20a an option to make a section from a number of alternatives subjective user states (e.g., are you happy, very happy, sad, or very sad?).

In various implementations, the subjective user state data acquisition operation 1-302 may include an operation 1-457 for acquiring at least one of the first subjective user state or the second subjective user state at a server as depicted in FIG. 1-4d. For instance, the subjective user state data acquisition module 1-102 of the computing device 1-10 acquiring at least one of the first subjective user state 1-60a (e.g., user is “sleepy”) or the second subjective user state 1-60b (e.g., user is again “sleepy”) at a server (e.g., computing device 1-10 being a network server).

In various implementations, the subjective user state data acquisition operation 1-302 may include an operation 1-458 for acquiring at least one of the first subjective user state or the second subjective user state at a handheld device as depicted in FIG. 1-4d. For instance, the subjective user state data acquisition module 1-102 of the computing device 1-10 acquiring at least one of the first subjective user state 1-60a (e.g., user is “dizzy”) or the second subjective user state 1-60b (e.g., user is again “dizzy”) at a handheld device (e.g., computing device 1-10 being a mobile phone or a PDA).

In various implementations, the subjective user state data acquisition operation 1-302 may include an operation 1-460 for acquiring at least one of the first subjective user state or the second subjective user state at a peer-to-peer network component device as depicted in FIG. 1-4d. For instance, the subjective user state data acquisition module 1-102 of the computing device 1-10 acquiring at least one of the first subjective user state 1-60a (e.g., user feels “alert”) or the second subjective user state 1-60b (e.g., user again feels “alert”) at a peer-to-peer network component device (e.g., computing device 1-10).

In various implementations, the subjective user state data acquisition operation 1-302 may include an operation 1-462 for acquiring at least one of the first subjective user state or the second subjective user via a Web 2.0 construct as depicted in FIG. 1-4d. For instance, the subjective user state data acquisition module 1-102 of the computing device 1-10 acquiring at least one of the first subjective user state 1-60a (e.g., user feels ill) or the second subjective user 1-60b (e.g., user again feels ill) via a Web 2.0 construct.

In some implementations, the subjective user state data acquisition operation 1-302 may include an operation 1-464 for acquiring data that indicates a first subjective user state that occurred at least partially concurrently with an occurrence of a first objective occurrence associated with the user as depicted in FIG. 1-4e. For instance, the subjective user state data acquisition module 1-102 of the computing device 1-10 acquiring (e.g., via network interface 1-120 or via user interface 1-122) data that indicates a first subjective user state that occurred at least partially concurrently with an occurrence of a first objective occurrence associated with the user 1-20*.

In some implementations, the subjective user state data acquisition operation 1-302 may include an operation 1-466 for acquiring data that indicates a second subjective user state that occurred at least partially concurrently with an occurrence of a second objective occurrence associated with the user as depicted in FIG. 1-4e. For instance, the subjective user state data acquisition module 1-102 of the computing device 1-10 acquiring (e.g., via network interface 1-120 or via user interface 1-122) data that indicates a second subjective user state that occurred at least partially concurrently with an occurrence of a second objective occurrence associated with the user 1-20*.

In some implementations, the subjective user state data acquisition operation 1-302 may include an operation 1-468 for acquiring data that indicates a first subjective user state that occurred prior to an occurrence of a first objective occurrence associated with the user as depicted in FIG. 1-4e. For instance, the subjective user state data acquisition module 1-102 of the computing device 1-10 acquiring (e.g., via network interface 1-120 or via user interface 1-122) data that indicates a first subjective user state that occurred prior to an occurrence of a first objective occurrence associated with the user 1-20* (e.g., first subjective user state occurred within a predefined time increment before the occurrence of the first objective occurrence such as occurring within 15 minutes, 30 minutes, 1 hour, 1 day, or some other time increment before the occurrence of the first objective occurrence).

In some implementations, the subjective user state data acquisition operation 1-302 may include an operation 1-470 for acquiring data that indicates a second subjective user state that occurred prior to an occurrence of a second objective occurrence associated with the user as depicted in FIG. 1-4e. For instance, the subjective user state data acquisition module 1-102 of the computing device 1-10 acquiring (e.g., via network interface 1-120 or via user interface 1-122) data that indicates a second subjective user state that occurred prior to an occurrence of a second objective occurrence associated with the user 1-20* (e.g., second subjective user state occurred within a predefined time increment before the occurrence of the second objective occurrence such as occurring within 15 minutes, 30 minutes, 1 hour, 1 day, or some other predefined time increment before the occurrence of the second objective occurrence).

In some implementations, the subjective user state data acquisition operation 1-302 may include an operation 1-472 for acquiring data that indicates a first subjective user state that occurred subsequent to an occurrence of a first objective occurrence associated with the user as depicted in FIG. 1-4e. For instance, the subjective user state data acquisition module 1-102 of the computing device 1-10 acquiring (e.g., via network interface 1-120 or via user interface 1-122) data that indicates a first subjective user state that occurred subsequent to an occurrence of a first objective occurrence associated with the user 1-20* (e.g., first subjective user state occurred within a predefined time increment after the occurrence of the first objective occurrence such as occurring within 15 minutes, 30 minutes, 1 hour, 1 day, or some other predefined time increment after the occurrence of the first objective occurrence).

In some implementations, the subjective user state data acquisition operation 1-302 may include an operation 1-474 for acquiring data that indicates a second subjective user state that occurred subsequent to an occurrence of a second objective occurrence associated with the user as depicted in FIG. 1-4e. For instance, the subjective user state data acquisition module 1-102 of the computing device 1-10 acquiring (e.g., via network interface 1-120 or via user interface 1-122) data that indicates a second subjective user state that occurred subsequent to an occurrence of a second objective occurrence associated with the user 1-20* (e.g., second subjective user state occurred within a predefined time increment after the occurrence of the second objective occurrence such as occurring within 15 minutes, 30 minutes, 1 hour, 1 day, or some other time increment after the occurrence of the second objective occurrence).

Referring back to FIG. 1-3, in various implementations the objective context data acquisition operation 1-304 may include one or more additional operations as illustrated in FIGS. 1-5a, 1-5b, 1-5c, 1-5d, and 1-5e. For example, in some implementations, the objective context data acquisition operation 1-304 may include a reception operation 1-502 for receiving the objective context data as depicted in FIG. 1-5a. For instance, the objective context data reception module 1-208 of the computing device 1-10 receiving (e.g., via a network interface 1-120 or via a user interface 1-122) the objective context data 1-70a, 1-70b, or 1-70c.

In some implementations, the reception operation 1-502 may further include one or more additional operations. For example, in some implementations, the reception operation 1-502 may include an operation 1-504 for receiving the objective context data from at least one of a wireless network or wired network as depicted in FIG. 1-5a. For instance, the objective context data reception module 1-208 of the computing device 1-10 receiving (e.g., via network interface 1-120) the objective context data 1-70a, 1-70b, or 1-70c from at least one of a wireless network or wired network 1-40.

In some implementations, the reception operation 1-502 may include an operation 1-506 for receiving the objective context data via one or more blog entries as depicted in FIG. 1-5a. For instance, the objective context data reception module 1-208 of the computing device 1-10 receiving (e.g., via network interface 1-120) the objective context data 1-70a or 1-70c via one or more blog entries (e.g., microblog entries).

In some implementations, the reception operation 1-502 may include an operation 1-507 for receiving the objective context data via one or more status reports as depicted in FIG. 1-5a. For instance, the objective context data reception module 1-208 of the computing device 1-10 receiving (e.g., via network interface 1-120) the objective context data 1-70a or 1-70c via one or more status reports (e.g., social network status reports).

In some implementations, the reception operation 1-502 may include an operation 1-508 for receiving the objective context data via a Web 2.0 construct as depicted in FIG. 1-5a. For instance, the objective context data reception module 1-208 of the computing device 1-10 receiving (e.g., via network interface 1-120) the objective context data 1-70a, 1-70b, or 1-70c via a Web 2.0 construct (e.g., web 2.0 application 1-230).

In various implementations, the reception operation 1-502 may include an operation 1-510 for receiving the objective context data from one or more third party sources as depicted in FIG. 1-5b. For instance, the objective context data reception module 1-208 of the computing device 1-10 receiving (e.g., via network interface 1-120) the objective context data 1-70a from one or more third party sources 1-50.

In some implementations, operation 1-510 may further include an operation 1-512 for receiving the objective context data from at least one of a health care professional, a pharmacy, a hospital, a health care organization, a health monitoring service, or a health care clinic as depicted in FIG. 1-5b. For instance, the objective context data reception module 1-208 of the computing device 1-10 receiving (e.g., via network interface 1-120) the objective context data 1-70a from at least one of a health care professional, a pharmacy, a hospital, a health care organization, a health monitoring service, or a health care clinic.

In some implementations, operation 1-510 may further include an operation 1-514 for receiving the objective context data from a content provider as depicted in FIG. 1-5b. For instance, the objective context data reception module 1-208 of the computing device 1-10 receiving (e.g., via network interface 1-120) the objective context data 1-70a from a content provider.

In some implementations, operation 1-510 may further include an operation 1-516 for receiving the objective context data from at least one of a school, a place of employment, or a social group as depicted in FIG. 1-5b. For instance, the objective context data reception module 1-208 of the computing device 1-10 receiving (e.g., via network interface 1-120) the objective context data 1-70a from at least one of a school, a place of employment, or a social group.

In various implementations, the reception operation 1-502 may include an operation 1-518 for receiving the objective context data from one or more sensors configured to sense one or more objective occurrences associated with the user as depicted in FIG. 1-5c. For instance, the objective context data reception module 1-208 of the computing device 1-10 receiving (e.g., via network interface 1-120) the objective context data 1-70b from one or more sensors 1-35 configured to sense one or more objective occurrences (e.g., blood pressure, blood sugar level, location of the user 1-20a, and so forth) associated with the user 1-20a.

In some implementations, operation 1-518 may further include an operation 1-520 for receiving the objective context data from a physical activity sensor device as depicted in FIG. 1-5c. For instance, the objective context data reception module 1-208 of the computing device 1-10 receiving (e.g., via network interface 1-120) the objective context data 1-70b from a physical activity sensor device (e.g., a pedometer or a sensor on an exercise machine).

In some implementations, operation 1-518 may further include an operation 1-521 for receiving the objective context data from a global positioning system (GPS) device as depicted in FIG. 1-5c. For instance, the objective context data reception module 1-208 of the computing device 1-10 receiving (e.g., via network interface 1-120) the objective context data 1-70b from a global positioning system (GPS) device (e.g., mobile device 1-30).

In some implementations, operation 1-518 may further include an operation 1-522 for receiving the objective context data from a physiological sensor device as depicted in FIG. 1-5c. For instance, the objective context data reception module 1-208 of the computing device 1-10 receiving (e.g., via network interface 1-120) the objective context data 1-70b from a physiological sensor device (e.g., blood pressure monitor, heart rate monitor, glucometer, and so forth).

In some implementations, operation 1-518 may further include an operation 1-523 for receiving the objective context data from an image capturing device as depicted in FIG. 1-5c. For instance, the objective context data reception module 1-208 of the computing device 1-10 receiving (e.g., via network interface 1-120) the objective context data 1-70b from an image capturing device (e.g., video or digital camera).

In various implementations, the reception operation 1-502 may include an operation 1-524 for receiving the objective context data from the user as depicted in FIG. 1-5c. For instance, the objective context data reception module 1-208 of the computing device 1-10 receiving (e.g., via network interface 1-120 or via user interface 1-122) the objective context data 1-70c from the user 1-20*.

In various implementations, the objective context data acquisition operation 1-304 of FIG. 1-3 may include an operation 1-525 for acquiring the objective context data from a memory as depicted in FIG. 1-5c. For instance, the subjective user state data acquisition module 1-102 of the computing device 1-10 acquiring the objective context data 1-70d (e.g., tidal chart or moon phase chart) from memory 1-140.

In various implementations, the objective context data acquisition operation 1-304 may include an operation 1-528 for acquiring at least a first context data indicative of a first objective occurrence associated with a user and a second context data indicative of a second objective occurrence associated with the user that is equivalent to the first objective occurrence as depicted in FIG. 1-5c. For instance, the objective context data acquisition module 1-104 of the computing device 1-10 acquiring at least a first context data indicative of a first objective occurrence (e.g., cloudy weather) associated with a user 1-20* and a second context data indicative of a second objective occurrence (e.g., cloudy weather) associated with the user 1-20* that is equivalent to the first objective occurrence.

In various implementations, the objective context data acquisition operation 1-304 may include an operation 1-530 for acquiring at least a first context data indicative of a first objective occurrence associated with a user and a second context data indicative of a second objective occurrence associated with the user that is proximately equivalent to the first objective occurrence as depicted in FIG. 1-5c. For instance, the objective context data acquisition module 1-104 of the computing device 1-10 acquiring at least a first context data indicative of a first objective occurrence (e.g., drank 8 cans of beer) associated with a user 1-20* and a second context data indicative of a second objective occurrence (e.g., drank 7 cans of beer) associated with the user 1-20* that is proximately equivalent to the first objective occurrence.

In various implementations, the objective context data acquisition operation 1-304 may include an operation 1-532 for acquiring a first time stamp associated with the first objective occurrence and a second time stamp associated with the second objective occurrence as depicted in FIG. 1-5d. For instance, the objective context data acquisition module 1-104 of the computing device 1-10 acquiring (e.g., receiving via network interface 1-120 or generating via time stamp module 1-124) a first time stamp associated with the first objective occurrence (e.g., jogged for 40 minutes) and a second time stamp associated with the second objective occurrence (e.g., jogged for 38 minutes).

In various implementations, the objective context data acquisition operation 1-304 may include an operation 1-534 for acquiring a first context data indicative of a first activity performed by the user and a second context data indicative of a second activity performed by the user as depicted in FIG. 1-5d. For instance, the objective context data acquisition module 1-104 of the computing device 1-10 acquiring (e.g., via network interface 1-120 or via user interface 1-122) a first context data indicative of a first activity (e.g., ingesting a particular food, medicine, or nutraceutical) performed by the user and a second context data indicative of a second activity (e.g., ingesting the same or similar particular food, medicine, or nutraceutical) performed by the user 1-20*.

In some implementations, operation 1-534 may also include an operation 1-536 for acquiring a first context data indicative of an ingestion by the user of a first medicine and a second context data indicative of an ingestion by the user of a second medicine as depicted in FIG. 1-5d. For instance, the objective context data acquisition module 1-104 of the computing device 1-10 acquiring (e.g., via network interface 1-120 or via user interface 1-122) a first context data indicative of an ingestion by the user 1-20* of a first medicine (e.g., 600 mg dose of ibuprofen) and a second context data indicative of an ingestion by the user of a second medicine e.g., another 600 mg dose of ibuprofen).

In some implementations, operation 1-534 may also include an operation 1-538 for acquiring a first context data indicative of an ingestion by the user of a first food and a second context data indicative of an ingestion by the user of a second food as depicted in FIG. 1-5d. For instance, the objective context data acquisition module 1-104 of the computing device 1-10 acquiring (e.g., via network interface 1-120 or via user interface 1-122) a first context data indicative of an ingestion by the user 1-20* of a first food (e.g., 16 ounces of orange juice) and a second context data indicative of an ingestion by the user 1-20* of a second food (e.g., another 16 ounces of orange juice).

In some implementations, operation 1-534 may also include an operation 1-540 for acquiring a first context data indicative of an ingestion by the user of a first nutraceutical and a second context data indicative of an ingestion by the user of a second nutraceutical as depicted in FIG. 1-5d. For instance, the objective context data acquisition module 1-104 of the computing device 1-10 acquiring (e.g., via network interface 1-120 or via user interface 1-122) a first context data indicative of an ingestion by the user 1-20* of a first nutraceutical (e.g., a serving of ginkgo biloba) and a second context data indicative of an ingestion by the user 1-20* of a second nutraceutical (e.g., a serving of ginkgo biloba).

In some implementations, operation 1-534 may also include an operation 1-542 for acquiring a first context data indicative of a first exercise routine executed by the user and a second context data indicative of a second exercise routine executed by the user as depicted in FIG. 1-5d. For instance, the objective context data acquisition module 1-104 of the computing device 1-10 acquiring (e.g., via network interface 1-120 or via user interface 1-122) a first context data indicative of a first exercise routine (e.g., exercising 30 minutes on a treadmill machine) executed by the user 1-20* and a second context data indicative of a second exercise routine (e.g., exercising another 30 minutes on the treadmill machine) executed by the user 1-20*.

In some implementations, operation 1-534 may also include an operation 1-544 for acquiring a first context data indicative of a first social activity executed by the user and a second context data indicative of a second social activity executed by the user as depicted in FIG. 1-5d. For instance, the objective context data acquisition module 1-104 of the computing device 1-10 acquiring (e.g., via network interface 1-120 or via user interface 1-122) a first context data indicative of a first social activity (e.g., going out on a blind date) executed by the user 1-20* and a second context data indicative of a second social activity (e.g., going out again on a blind date) executed by the user 1-20*.

In some implementations, operation 1-534 may also include an operation 1-546 for acquiring a first context data indicative of a first work activity executed by the user and a second context data indicative of a second work activity executed by the user as depicted in FIG. 1-5d. For instance, the objective context data acquisition module 1-104 of the computing device 1-10 acquiring (e.g., via network interface 1-120 or via user interface 1-122) a first context data indicative of a first work activity (e.g., two hours of overtime work) executed by the user 1-20* and a second context data indicative of a second work activity (e.g., another two hours of overtime work) executed by the user 1-20*.

In various implementations, the objective context data acquisition operation 1-304 of FIG. 1-3 may include an operation 1-548 for acquiring a first context data indicative of a first activity performed by a third party and a second context data indicative of a second activity performed by the third party as depicted in FIG. 1-5e. For instance, the objective context data acquisition module 1-104 of the computing device 1-10 acquiring (e.g., via network interface 1-120 or via user interface 1-122) a first context data indicative of a first activity performed by a third party (e.g., dental procedure performed by a dentist on the user 1-20* as reported by the dentist or by the user 1-20*) and a second context data indicative of a second activity performed by the third party (e.g., another dental procedure performed by a dentist on the user 1-20* as reported by the dentist or by the user 1-20*).

In some implementations, operation 1-548 may further include an operation 1-550 for acquiring a first context data indicative of a first social activity executed by the third party and a second context data indicative of a second social activity executed by the third party as depicted in FIG. 1-5e. For instance, the objective context data acquisition module 1-104 of the computing device 1-10 acquiring (e.g., via network interface 1-120 or via user interface 1-122) a first context data indicative of a first social activity executed by the third party (e.g., spouse going away to visit a relative) and a second context data indicative of a second social activity executed by the third party (e.g., spouse going away again to visit a relative).

In some implementations, operation 1-548 may further include an operation 1-552 for acquiring a first context data indicative of a first work activity executed by the third party and a second context data indicative of a second work activity executed by the third party as depicted in FIG. 1-5e. For instance, the objective context data acquisition module 1-104 of the computing device 1-10 acquiring (e.g., via network interface 1-120 or via user interface 1-122) a first context data indicative of a first work activity executed by the third party (e.g., boss meeting with the user 1-20*) and a second context data indicative of a second work activity executed by the third party (e.g., boss meeting with the user 1-20*).

In various implementations, the objective context data acquisition operation 1-304 of FIG. 1-3 may include an operation 1-554 for acquiring a first context data indicative of a first physical characteristic of the user and a second context data indicative of a second physical characteristic of the user as depicted in FIG. 1-5e. For instance, the objective context data acquisition module 1-104 of the computing device 1-10 acquiring (e.g., via network interface 1-120 or via user interface 1-122) a first context data indicative of a first physical characteristic of the user 1-20* (e.g., high blood sugar level) and a second context data indicative of a second physical characteristic of the user 1-20* (e.g., another high blood sugar level).

In various implementations, the objective context data acquisition operation 1-304 may include an operation 1-556 for acquiring a first context data indicative of a first external event and a second context data indicative of a second external event as depicted in FIG. 1-5e. For instance, the objective context data acquisition module 1-104 of the computing device 1-10 acquiring (e.g., via network interface 1-120 or via user interface 1-122) a first context data indicative of a first external event (e.g., stock market drops 500 points) and a second context data indicative of a second external event (e.g., stock market again drops 500 points).

In various implementations, the objective context data acquisition operation 1-304 may include an operation 1-558 for acquiring a first context data indicative of a first location of the user and a second context data indicative of a second location of the user as depicted in FIG. 1-5e. For instance, the objective context data acquisition module 1-104 of the computing device 1-10 acquiring (e.g., via network interface 1-120 or via user interface 1-122) a first context data indicative of a first location (e.g., Hawaii) of the user 1-20* (e.g., during a first point in time) and a second context data indicative of a second location (e.g., Hawaii) of the user 1-20* (e.g., during second point in time).

In various implementations, the objective context data acquisition operation 1-304 may include an operation 1-560 for acquiring a first time stamp associated with the first objective occurrence and a second time stamp associated with the second objective occurrence as depicted in FIG. 1-5e. For instance, the objective context data acquisition module 1-104 of the computing device 1-10 acquiring (e.g., via network interface 1-120 or via time stamp module 1-124) a first time stamp associated with the first objective occurrence (e.g., consumption of medicine) and a second time stamp associated with the second objective occurrence (e.g., consumption again of the same or similar medicine).

Referring back to FIG. 1-3, the correlation operation 1-306 may include one or more additional operations as illustrated in FIG. 1-6a and 1-6b. For example, in various implementations, the correlation operation 1-306 may include an operation 1-602 for determining at least an extent of time difference between the first subjective user state associated with the user and the first objective occurrence associated with the user as depicted in FIG. 1-6a. For instance, the subjective user state and objective occurrence time difference determination module 1-214 (see FIG. 1-2c) of the computing device 1-10 determining at least an extent of time difference between the occurrence of the first subjective user state (e.g., an extreme hangover) associated with the user 1-20* and the occurrence of the first objective occurrence (e.g., drinking four shots of whiskey) associated with the user 1-20* by, for example, comparing a time stamp associated with the first subjective user state with a time stamp associated with the first objective occurrence.

In some implementations, operation 1-602 may further include an operation 1-604 for determining at least an extent of time difference between the second subjective user state associated with the user and the second objective occurrence associated with the user as depicted in FIG. 1-6a. For instance, the subjective user state and objective occurrence time difference determination module 1-214 of the computing device 1-10 determining at least an extent of time difference between the second subjective user state (e.g., a slight hangover) associated with the user 1-20* and the second objective occurrence (e.g., again drinking two shots of whiskey) associated with the user 1-20* by, for example, comparing a time stamp associated with the second subjective user state with a time stamp associated with the second objective occurrence.

In some implementations, operation 1-604 may further include an operation 1-606 for comparing the extent of time difference between the first subjective user state and the first objective occurrence with the extent of time difference between the second subjective user state and the second objective occurrence as depicted in FIG. 1-6a. For instance, the comparison module 1-216 (see FIG. 1-2c) of the computing device 1-10 comparing the extent of time difference between the first subjective user state (e.g., an extreme hangover) and the first objective occurrence (e.g., drinking four shots of whiskey) with the extent of time difference between the second subjective user state (e.g., a slight hangover) and the second objective occurrence (e.g., drinking two shots of whiskey).

In various implementations, the correlation operation 1-306 may include an operation 1-608 for determining an extent of difference between the first subjective user state and the second subjective user state associated with the user as depicted in FIG. 1-6a. For instance, the subjective user state difference determination module 1-210 (see FIG. 1-2c) of the computing device 1-10 determining an extent of difference between the first subjective user state (e.g., an extreme hangover) and the second subjective user state (e.g., a slight hangover) associated with the user 1-20*. Such an operation may be implemented to, for example, determine whether there is a relationship between a subjective user state (e.g., a level of hangover) and an objective occurrence (e.g., amount of consumption of whiskey) or in determining a strength of correlation between the subjective user state and the objective occurrence.

In various implementations, the correlation operation 1-306 may include an operation 1-610 for determining an extent of difference between the first objective occurrence and the second objective occurrence associated with the user as depicted in FIG. 1-6a. For instance, the objective occurrence difference determination module 1-212 (see FIG. 1-2c) determining an extent of difference between the first objective occurrence (e.g., drinking four shots of whiskey) and the second objective occurrence (e.g., drinking two shots of whiskey) associated with the user 1-20*. Such an operation may be implemented to, for example, determine whether there is a relationship between a subjective user state (e.g., a level of hangover) and an objective occurrence (e.g., amount of consumption of whiskey) or in determining a strength of correlation between the subjective user state and the objective occurrence.

In various implementations, the correlation operation 1-306 may include an operation 1-612 for determining a strength of the correlation between the subjective user state data and the objective context data as depicted in FIG. 1-6a. For instance, the strength of correlation determination module 1-218 (see FIG. 1-2c) of the computing device 1-10 determining a strength of the correlation between the subjective user state data (e.g., hangover) and the objective context data (e.g., drinking whiskey).

In some implementations, the correlation operation 1-306 may include an operation 1-614 for determining whether the first subjective user state occurred after occurrence of the first objective occurrence associated with the user as depicted in FIG. 1-6b. For instance, the determination module 1-219 of the computing device 1-10 determining whether the first subjective user state (e.g., upset stomach) occurred after occurrence of the first objective occurrence (e.g., eating a banana) associated with the user 1-20* (e.g., determining whether the first subjective user state occurred within a predefined time increment after the occurrence of the first objective occurrence such as determining whether the first subjective user state occurring within 15 minutes, 30 minutes, 1 hour, 1 day, or some other time increment after the occurrence of the first objective occurrence).

In some implementations, the correlation operation 1-306 may include an operation 1-616 for determining whether the second subjective user state occurred after occurrence of the second objective occurrence associated with the user as depicted in FIG. 1-6b. For instance, the determination module 1-219 of the computing device 1-10 determining whether the second subjective user state (e.g., upset stomach) occurred after occurrence of the second objective occurrence (e.g., eating a banana) associated with the user 1-20* (e.g., determining whether the second subjective user state occurred within a predefined time increment after the occurrence of the second objective occurrence such as determining whether the first subjective user state occurring within 15 minutes, 30 minutes, 1 hour, 1 day, or some other time increment after the occurrence of the second objective occurrence).

In some implementations, the correlation operation 1-306 may include an operation 1-618 for determining whether the first subjective user state occurred before occurrence of the first objective occurrence associated with the user as depicted in FIG. 1-6b. For instance, the determination module 1-219 of the computing device 1-10 determining whether the first subjective user state (e.g., feeling gloomy) occurred before occurrence of the first objective occurrence (e.g., raining weather) associated with the user 1-20* (e.g., determining whether the first subjective user state occurred within a predefined time increment before the occurrence of the first objective occurrence such as determining whether the first subjective user state occurring within 15 minutes, 30 minutes, 1 hour, 1 day, or some other time increment before the occurrence of the first objective occurrence).

In some implementations, the correlation operation 1-306 may include an operation 1-620 for determining whether the second subjective user state occurred before occurrence of the second objective occurrence associated with the user as depicted in FIG. 1-6b. For instance, the determination module 1-219 of the computing device 1-10 determining whether the second subjective user state (e.g., feeling gloomy) occurred before occurrence of the second objective occurrence (e.g., raining weather) associated with the user 1-20* (e.g., determining whether the second subjective user state occurred within a predefined time increment before the occurrence of the second objective occurrence such as determining whether the second subjective user state occurring within 15 minutes, 30 minutes, 1 hour, 1 day, or some other time increment before the occurrence of the second objective occurrence).

In some implementations, the correlation operation 1-306 may include an operation 1-622 for determining whether the first subjective user state occurred at least partially concurrently with occurrence of the first objective occurrence associated with the user as depicted in FIG. 1-6b. For instance, the determination module 1-219 of the computing device 1-10 determining whether the first subjective user state (e.g., happiness) occurred at least partially concurrently with occurrence of the first objective occurrence (e.g., boss left town) associated with the user 1-20*.

In some implementations, the correlation operation 1-306 may include an operation 1-624 for determining whether the second subjective user state occurred at least partially concurrently with occurrence of the second objective occurrence associated with the user as depicted in FIG. 1-6b. For instance, the determination module 1-219 of the computing device 1-10 determining whether the second subjective user state (e.g., happiness) occurred at least partially concurrently with occurrence of the second objective occurrence (e.g., boss left town) associated with the user 1-20*.

FIG. 1-7 illustrates another operational flow 1-700 related to acquisition and correlation of subjective user state data and objective context data, and for presenting one or more results of the correlation in accordance with various embodiments. The operational flow 1-700 may include at least a subjective user state data acquisition operation 1-702, an objective context data acquisition operation 1-704, and a correlation operation 1-706 that corresponds to and mirror the subjective user state data acquisition operation 1-302, the objective context data acquisition operation 1-304, and the correlation operation 1-306, respectively, of the operational flow 1-300 of FIG. 1-3. In addition, operational flow 1-700 includes a presentation operation 1-708 for presenting one or more results of the correlating of the subjective user state data and the objective context data. For instance, the presentation module 1-108 of the computing device 1-10 presenting (e.g., displaying via the user interface 1-122 or transmitting via the network interface 1-120) one or more results of the correlating of the subjective user state data 1-60 with the objective context data 1-70*.

The presentation operation 1-702 may include one or more additional operations in various alternative implementations as illustrated in FIGS. 1-8a and 1-8b. For example, in some implementations, the presentation operation 1-702 may include a transmission operation 1-801 for transmitting the one or more results as depicted in FIG. 1-8a. For instance, the transmission module 1-220 (see FIG. 1-2d) of the computing device 1-10 transmitting (e.g., via the network interface 1-120) the one or more results of the correlation of the subjective user state data with the objective context data.

In some implementations, the transmission operation 1-801 may include an operation 1-802 for transmitting the one or more results to the user as depicted in FIG. 1-8a. For instance, the transmission module 1-220 of the computing device 1-10 transmitting (e.g., via the network interface 1-120) the one or more results of the correlating of the subjective user state data 1-60 with the objective context data 1-70* to the user 1-20a.

In some implementations, the transmission operation 1-801 may include an operation 1-804 for transmitting the one or more results to one or more third parties as depicted in FIG. 1-8a. For instance, the transmission module 1-220 of the computing device 1-10 transmitting (e.g., via the network interface 1-120) the one or more results of the correlating of the subjective user state data 1-60 with the objective context data 1-70* to one or more third parties 1-50.

In some implementations, the presentation operation 1-708 may include an operation 1-806 for displaying the one or more results to the user via a user interface as depicted in FIG. 1-8a. For instance, the display module 1-222 (see FIG. 1-2d) of the computing device 1-10 displaying the one or more results of the correlating of the subjective user state data 1-60 with the objective context data 1-70* to the user 1-20* via a user interface 1-122 (e.g., display monitor and/or an audio device). Note that as used herein “displaying” may refer to the showing of the one or more results through, for example, a display monitor, and/or audibly indicating the one or more results via an audio device.

In some implementations, the presentation operation 1-708 may include an operation 1-808 for presenting an indication of a sequential relationship between a subjective user state and an objective occurrence associated with the user as depicted in FIG. 1-8a. For instance, the presentation module 1-108 of the computing device 1-10 presenting (e.g., via a network interface 1-120 or a user interface 1-122) an indication of a sequential relationship between a subjective user state (e.g., hangover) and an objective occurrence (e.g., consuming at least two shots of whiskey) associated with the user 1-20*. In this example, the presented indication may indicate that the user 1-20* will have a headache after drinking two or more shots of whiskey.

In some implementations, the presentation operation 1-708 may include an operation 1-810 for presenting a prediction of a future subjective user state resulting from a future occurrence associated with the user as depicted in FIG. 1-8a. For instance, the presentation module 1-108 of the computing device 1-10 presenting (e.g., via a network interface 1-120 or a user interface 1-122) a prediction of a future subjective user state (e.g., sadness) resulting from a future occurrence (e.g., missing son's football game) associated with the user 1-20*. In this example, the presented indication may indicate that the user 1-20* will be sad if the user misses his son's football game.

In some implementations, the presentation operation 1-708 may include an operation 1-811 for presenting a prediction of a future subjective user state resulting from a past occurrence associated with the user as depicted in FIG. 1-8a. For instance, the presentation module 1-108 of the computing device 1-10 presenting (e.g., via a network interface 1-120 or a user interface 1-122) a prediction of a future subjective user state (e.g., you will get a stomach ache) resulting from a past occurrence (e.g., ate a banana) associated with the user 1-20*.

In some implementations, the presentation operation 1-708 may include an operation 1-812 for presenting a past subjective user state associated with a past occurrence associated with the user as depicted in FIG. 1-8a. For instance, the presentation module 1-108 of the computing device 1-10 presenting (e.g., via a network interface 1-120 or a user interface 1-122) a past subjective user state associated with a past occurrence associated with the user 1-20* (e.g., “did you know that whenever the user drinks green tea, the user always feels alert?”).

In some implementations, the presentation operation 1-708 may include an operation 1-814 for presenting a recommendation for a future action as depicted in FIG. 1-8a. For instance, the presentation module 1-108 of the computing device 1-10 presenting (e.g., via a network interface 1-120 or a user interface 1-122) a recommendation for a future action (e.g., “you should take a dose of brand x aspirin for your headaches”). Note that in this example, the consumption of the brand x aspirin is the objective occurrence and the stopping or easing of a headache is the subjective user state.

In particular implementations, operation 1-814 may further include an operation 1-816 for presenting a justification for the recommendation as depicted in FIG. 1-8a. For instance, the presentation module 1-108 of the computing device 1-10 presenting (e.g., via a network interface 1-120 or a user interface 1-122) a justification for the recommendation (e.g., “brand x aspirin in the past seems to work the best for your headaches”).

In some implementations, the presentation operation 1-708 may include an operation 1-818 for presenting an indication of a strength of correlation between the subjective user state data and the objective context data as depicted in FIG. 1-8b. For instance, the presentation module 1-108 of the computing device 1-10 presenting (e.g., via a network interface 1-120 or a user interface 1-122) an indication of a strength of correlation between the subjective user state data 1-60 and the objective context data 1-70* (e.g., “you sometimes get a headache after a night of drinking whiskey”).

In various implementations, the presentation operation 1-708 may include an operation 1-820 for presenting one or more results of the correlating in response to a reporting of an occurrence of a third objective occurrence associated with the user as depicted in FIG. 1-8b. For instance, the presentation module 1-108 of the computing device 1-10 presenting (e.g., via a network interface 1-120 or a user interface 1-122) one or more results of the correlating (e.g., going to Hawaii causes user's allergies to act up) in response to a reporting (e.g., via a microblog entry or by other means) of an occurrence of a third objective occurrence (e.g., leaving for Hawaii) associated with the user 1-20*.

In various implementations, operation 1-820 may include one or more additional operations. For example, in some implementations, operation 1-820 may include an operation 1-822 for presenting one or more results of the correlating in response to a reporting of an event that was executed by the user as depicted in FIG. 1-8b. For instance, the presentation module 1-108 of the computing device 1-10 presenting (e.g., via a network interface 1-120 or a user interface 1-122) one or more results of the correlating (e.g., drinking two or more shots of whiskey causes a hangover) in response to a reporting of an event (e.g., reporting a shot of whiskey being drunk) that was executed by the user 1-20*.

In some implementations, operation 1-820 may include an operation 1-824 for presenting one or more results of the correlating in response to a reporting of an event that was executed by a third party as depicted in FIG. 1-8b. For instance, the presentation module 1-108 of the computing device 1-10 presenting (e.g., via a network interface 1-120 or a user interface 1-122) one or more results (e.g., indication that the user should not drive) of the correlating (e.g., vision is always blurry after being sedated by a dentist) in response to a reporting of an event (e.g., sedation of the user by the dentist) that was executed by a third party 1-50 (e.g., dentist).

In some implementations, operation 1-820 may include an operation 1-826 for presenting one or more results of the correlating in response to a reporting of an occurrence of an external event as depicted in FIG. 1-8b. For instance, the presentation module 1-108 of the computing device 1-10 presenting (e.g., via a network interface 1-120 or a user interface 1-122) one or more results of the correlating (e.g., indication that the user is always depressed after the stock market drops more than 500 points) in response to a reporting of an occurrence of an external event (e.g., stock market drops 700 points).

In various implementations, the presentation operation 1-708 may include an operation 1-828 for presenting one or more results of the correlating in response to a reporting of an occurrence of a third subjective user state as depicted in FIG. 1-8b. For instance, the presentation module 1-108 of the computing device 1-10 presenting (e.g., via a network interface 1-120 or a user interface 1-122) one or more results of the correlating (e.g., taking brand x aspirin stops headaches) in response to a reporting of an occurrence of a third subjective user state (e.g., user has a headache).

III. Correlating Data Indicating at Least One Subjective User State with Data Indicating at Least One Objective Occurrence Associated with a User

In the following detailed description, reference is made to the accompanying drawings, which form a part hereof. In the drawings, similar symbols typically identify similar components, unless context dictates otherwise. The illustrative embodiments described in the detailed description, drawings, and claims are not meant to be limiting. Other embodiments may be utilized, and other changes may be made, without departing from the spirit or scope of the subject matter presented here.

A recent trend that is becoming increasingly popular in the computing/communication field is to electronically record one's feelings, thoughts, and other aspects of the person's everyday life onto an open diary. One place where such open diaries are maintained are at social networking sites commonly known as “blogs” where one or more users may report or post their thoughts and opinions on various topics, the latest news, and various other aspects of the users' everyday life. The process of reporting or posting blog entries is commonly referred to as blogging. Other social networking sites may allow users to update their personal information via, for example, social network status reports in which a user may report or post for others to view the latest status or other aspects of the user.

A more recent development in social networking is the introduction and explosive growth of microblogs in which individuals or users (referred to as “microbloggers”) maintain open diaries at microblog websites (e.g., otherwise known as “twitters”) by continuously or semi-continuously posting microblog entries. A microblog entry (e.g., “tweet”) is typically a short text message that is usually not more than 140 characters long. The microblog entries posted by a microblogger may report on any aspect of the microblogger's daily life.

The various things that are typically posted through microblog entries may be categorized into one of at least two possible categories. The first category of things that may be reported through microblog entries are “objective occurrences” associated with the microblogger. Objective occurrences that are associated with a microblogger may be any characteristic, event, happening, or any other aspects associated with or are of interest to the microblogger that can be objectively reported by the microblogger, a third party, or by a device. These things would include, for example, food, medicine, or nutraceutical intake of the microblogger, certain physical characteristics of the microblogger such as blood sugar level or blood pressure that can be objectively measured, daily activities of the microblogger observable by others or by a device, the local weather, the stock market (which the microblogger may have an interest in), activities of others (e.g., spouse or boss) that may directly or indirectly affect the microblogger, and so forth.

A second category of things that may be reported or posted through microblogging entries include “subjective user states” of the microblogger. Subjective user states of a microblogger include any subjective state or status associated with the microblogger that can only be typically reported by the microblogger (e.g., generally cannot be reported by a third party or by a device). Such states including, for example, the subjective mental state of the microblogger (e.g., “I am feeling happy”), the subjective physical states of the microblogger (e.g., “my ankle is sore” or “my ankle does not hurt anymore” or “my vision is blurry”), and the subjective overall state of the microblogger (e.g., “I'm good” or “I'm well”). Note that the term “subjective overall state” as will be used herein refers to those subjective states that do not fit neatly into the other two categories of subjective user states described above (e.g., subjective mental states and subjective physical states). Although microblogs are being used to provide a wealth of personal information, they have only been primarily limited to their use as a means for providing commentaries and for maintaining open diaries.

In accordance with various embodiments, methods, systems, and computer program products are provided for, among other things, correlating subjective user state data (e.g., data that indicate one or more subjective user states of a user) with objective occurrence data (e.g., data that indicate one or more objective occurrences associated with the user). In doing so, a causal relationship between one or more objective occurrences (e.g., cause) and one or more subjective user states (e.g., result) associated with a user (e.g., a blogger or microblogger) may be determined in various alternative embodiments. For example, determining that the last time a user ate a banana (e.g., objective occurrence), the user felt “good” (e.g., subjective user state) or determining whenever a user eats a banana the user always or sometimes feels good. Note that an objective occurrence does not need to occur prior to a corresponding subjective user state but instead, may occur subsequent or concurrently with the incidence of the subjective user state. For example, a person may become “gloomy” (e.g., subjective user state) whenever it is about to rain (e.g., objective occurrence) or a person may become gloomy while (e.g., concurrently) it is raining.

As briefly described above, a “subjective user state” is in reference to any state or status associated with a user (e.g., a blogger or microblogger) at any moment or interval in time that only the user can typically indicate or describe. Such states include, for example, the subjective mental state of the user (e.g., user is feeling sad), the subjective physical state (e.g., physical characteristic) of the user that only the user can typically indicate (e.g., a backache or an easing of a backache as opposed to blood pressure which can be reported by a blood pressure device and/or a third party), and the subjective overall state of the user (e.g., user is “good”). Examples of subjective mental states include, for example, happiness, sadness, depression, anger, frustration, elation, fear, alertness, sleepiness, and so forth. Examples of subjective physical states include, for example, the presence, easing, or absence of pain, blurry vision, hearing loss, upset stomach, physical exhaustion, and so forth. Subjective overall states may include any subjective user states that cannot be categorized as a subjective mental state or as a subjective physical state. Examples of overall states of a user that may be subjective user states include, for example, the user being good, bad, exhausted, lack of rest, wellness, and so forth.

In contrast, “objective occurrence data,” which may also be referred to as “objective context data,” may include data that indicate one or more objective occurrences associated with the user that occurred at particular intervals or points in time. An objective occurrence may be any physical characteristic, event, happenings, or any other aspect associated with or is of interest to a user that can be objectively reported by at least a third party or a sensor device. Note, however, that such objective occurrence data does not have to be actually provided by a sensor device or by a third party, but instead, may be reported by the user himself or herself (e.g., via microblog entries). Examples of objectively reported occurrences that could be indicated by the objective occurrence data include, for example, a user's food, medicine, or nutraceutical intake, the user's location at any given point in time, the user's exercise routine, user's blood pressure, the weather at user's location, activities associated with third parties, the stock market, and so forth.

The term “correlating” as will be used herein is in reference to a determination of one or more relationships between at least two variables. In the following exemplary embodiments, the first variable is subjective user state data that represents at least one subjective user state of a user and the second variable is objective occurrence data that represents at least one objective occurrence associated with the user. In embodiments where the subjective user state data represents multiple subjective user states, each of the subjective user states represented by the subjective user state data may be the same or similar type of subjective user state (e.g., user being happy) at different intervals or points in time. In alternative embodiments, however, different types of subjective user state (e.g., user being happy and user being sad) may be represented by the subjective user state data. Similarly, in embodiments where multiple objective occurrences are represented by the objective occurrence data, each of the objective occurrences may represent the same or similar type of objective occurrence (e.g., user exercising) at different intervals or points in time, or, in alternative embodiments, different types of objective occurrence (e.g., user exercising and user resting).

Various techniques may be employed for correlating the subjective user state data with the objective occurrence data. For example, in some embodiments, correlating the objective occurrence data with the subjective user state data may be accomplished by determining a sequential pattern associated with at least one subjective user state indicated by the subjective user state data and at least one objective occurrence indicated by the objective occurrence data. In other embodiments, correlating of the objective occurrence data with the subjective user state data may involve determining multiple sequential patterns associated with multiple subjective user states and multiple objective occurrences.

As will be further described herein a sequential pattern, in some implementations, may merely indicate or represent the temporal relationship or relationships between at least one subjective user state and at least one objective occurrence (e.g., whether the incidence or occurrence of the at least one subjective user state occurred before, after, or at least partially concurrently with the incidence of the at least one objective occurrence). In alternative implementations, and as will be further described herein, a sequential pattern may indicate a more specific time relationship between the incidences of one or more subjective user states and the incidences of one or more objective occurrences. For example, a sequential pattern may represent the specific pattern of events (e.g., one or more objective occurrences and one or more subjective user states) that occurs along a timeline.

The following illustrative example is provided to describe how a sequential pattern associated with at least one subjective user state and at least one objective occurrence may be determined based, at least in part, on the temporal relationship between the incidence of the at least one subjective user state and the incidence of the at least one objective occurrence in accordance with some embodiments. For these embodiments, the determination of a sequential pattern may initially involve determining whether the incidence of the at least one subjective user state occurred within some predefined time increments of the incidence of the one objective occurrence. That is, it may be possible to infer that those subjective user states that did not occur within a certain time period from the incidence of an objective occurrence are not related or are unlikely related to the incidence of that objective occurrence.

For example, suppose a user during the course of a day eats a banana and also has a stomach ache sometime during the course of the day. If the consumption of the banana occurred in the early morning hours but the stomach ache did not occur until late that night, then the stomach ache may be unrelated to the consumption of the banana and may be disregarded. On the other hand, if the stomach ache had occurred within some predefined time increment, such as within 2 hours of consumption of the banana, then it may be concluded that there is a correlation or link between the stomach ache and the consumption of the banana. If so, a temporal relationship between the consumption of the banana and the occurrence of the stomach ache may be determined. Such a temporal relationship may be represented by a sequential pattern. Such a sequential pattern may simply indicate that the stomach ache (e.g., a subjective user state) occurred after (rather than before or concurrently) the consumption of banana (e.g., an objective occurrence).

As will be further described herein, other factors may also be referenced and examined in order to determine a sequential pattern and whether there is a relationship (e.g., causal relationship) between an objective occurrence and a subjective user state. These factors may include, for example, historical data (e.g., historical medical data such as genetic data or past history of the user or historical data related to the general population regarding stomach aches and bananas). Alternatively, a sequential pattern may be determined for multiple subjective user states and multiple objective occurrences. Such a sequential pattern may particularly map the exact temporal or time sequencing of the various events (e.g., subjective user states and/or objective occurrences). The determined sequential pattern may then be used to provide useful information to the user and/or third parties.

The following is another illustrative example of how subjective user state data may be correlated with objective occurrence data by determining multiple sequential patterns and comparing the sequential patterns with each other. Suppose, for example, a user such as a microblogger reports that the user ate a banana on a Monday. The consumption of the banana, in this example, is a reported first objective occurrence associated with the user. The user then reports that 15 minutes after eating the banana, the user felt very happy. The reporting of the emotional state (e.g., felt very happy) is, in this example, a reported first subjective user state. Thus, the reported incidence of the first objective occurrence (e.g., eating the banana) and the reported incidence of the first subjective user state (user felt very happy) on Monday may be represented by a first sequential pattern.

On Tuesday, the user reports that the user ate another banana (e.g., a second objective occurrence associated with the user). The user then reports that 20 minutes after eating the second banana, the user felt somewhat happy (e.g., a second subjective user state). Thus, the reported incidence of the second objective occurrence (e.g., eating the second banana) and the reported incidence of the second subjective user state (user felt somewhat happy) on Tuesday may be represented by a second sequential pattern. Note that in this example, the occurrences of the first subjective user state and the second subjective user state may be indicated by subjective user state data while the occurrences of the first objective occurrence and the second objective occurrence may be indicated by objective occurrence data.

By comparing the first sequential pattern with the second sequential pattern, the subjective user state data may be correlated with the objective occurrence data. In some implementations, the comparison of the first sequential pattern with the second sequential pattern may involve trying to match the first sequential pattern with the second sequential pattern by examining certain attributes and/or metrics. For example, comparing the first subjective user state (e.g., user felt very happy) of the first sequential pattern with the second subjective user state (e.g., user felt somewhat happy) of the second sequential pattern to see if they at least substantially match or are contrasting (e.g., being very happy in contrast to being slightly happy or being happy in contrast to being sad). Similarly, comparing the first objective occurrence (e.g., eating a banana) of the first sequential pattern may be compared to the second objective occurrence (e.g., eating of another banana) of the second sequential pattern to determine whether they at least substantially match or are contrasting.

A comparison may also be made to see if the extent of time difference (e.g., 15 minutes) between the first subjective user state (e.g., user being very happy) and the first objective occurrence (e.g., user eating a banana) matches or are at least similar to the extent of time difference (e.g., 20 minutes) between the second subjective user state (e.g., user being somewhat happy) and the second objective occurrence (e.g., user eating another banana). These comparisons may be made in order to determine whether the first sequential pattern matches the second sequential pattern. A match or substantial match would suggest, for example, that a subjective user state (e.g., happiness) is linked to an objective occurrence (e.g., consumption of banana).

As briefly described above, the comparison of the first sequential pattern with the second sequential pattern may include a determination as to whether, for example, the respective subjective user states and the respective objective occurrences of the sequential patterns are contrasting subjective user states and/or contrasting objective occurrences. For example, suppose in the above example the user had reported that the user had eaten a whole banana on Monday and felt very energetic (e.g., first subjective user state) after eating the whole banana (e.g., first objective occurrence). Suppose that the user also reported that on Tuesday he ate a half a banana instead of a whole banana and only felt slightly energetic (e.g., second subjective user state) after eating the half banana (e.g., second objective occurrence). In this scenario, the first sequential pattern (e.g., feeling very energetic after eating a whole banana) may be compared to the second sequential pattern (e.g., feeling slightly energetic after eating only a half of a banana) to at least determine whether the first subjective user state (e.g., being very energetic) and the second subjective user state (e.g., being slightly energetic) are contrasting subjective user states. Another determination may also be made during the comparison to determine whether the first objective occurrence (eating a whole banana) is in contrast with the second objective occurrence (e.g., eating a half of a banana).

In doing so, an inference may be made that eating a whole banana instead of eating only a half of a banana makes the user happier or eating more banana makes the user happier. Thus, the word “contrasting” as used here with respect to subjective user states refers to subjective user states that are the same type of subjective user states (e.g., the subjective user states being variations of a particular type of subjective user states such as variations of subjective mental states). Thus, for example, the first subjective user state and the second subjective user state in the previous illustrative example are merely variations of subjective mental states (e.g., happiness). Similarly, the use of the word “contrasting” as used here with respect to objective occurrences refers to objective states that are the same type of objective occurrences (e.g., consumption of food such as banana).

As those skilled in the art will recognize, a stronger correlation between the subjective user state data and the objective occurrence data could be obtained if a greater number of sequential patterns (e.g., if there was a third sequential pattern, a fourth sequential pattern, and so forth, that indicated that the user became happy or happier whenever the user ate bananas) are used as a basis for the correlation. Note that for ease of explanation and illustration, each of the exemplary sequential patterns to be described herein will be depicted as a sequential pattern of occurrence of a single subjective user state and occurrence of a single objective occurrence. However, those skilled in the art will recognize that a sequential pattern, as will be described herein, may also be associated with occurrences of multiple objective occurrences and/or multiple subjective user states. For example, suppose the user had reported that after eating a banana, he had gulped down a can of soda. The user then reported that he became happy but had an upset stomach. In this example, the sequential pattern associated with this scenario will be associated with two objective occurrences (e.g., eating a banana and drinking a can of soda) and two subjective user states (e.g., user having an upset stomach and feeling happy).

In some embodiments, and as briefly described earlier, the sequential patterns derived from subjective user state data and objective occurrence data may be based on temporal relationships between objective occurrences and subjective user states. For example, whether a subjective user state occurred before, after, or at least partially concurrently with an objective occurrence. For instance, a plurality of sequential patterns derived from subjective user state data and objective occurrence data may indicate that a user always has a stomach ache (e.g., subjective user state) after eating a banana (e.g., first objective occurrence).

FIGS. 2-1a and 2-1b illustrate an example environment in accordance with various embodiments. In the illustrated environment, an exemplary system 2-100 may include at least a computing device 2-10 (see FIG. 2-1b) that may be employed in order to, among other things, collect subjective user state data 2-60 and objective occurrence data 2-70* that are associated with a user 2-20*, and to correlate the subjective user state data 2-60 with the objective occurrence data 2-70*. Note that in the following, “*” indicates a wildcard. Thus, user 2-20* may indicate a user 2-20a or a user 2-20b of FIGS. 2-1a and 2-1b.

In some embodiments, the computing device 2-10 may be a network server in which case the computing device 2-10 may communicate with a user 2-20a via a mobile device 2-30 and through a wireless and/or wired network 2-40. A network server, as will be described herein, may be in reference to a network server located at a single network site or located across multiple network sites or a conglomeration of servers located at multiple network sites. The mobile device 2-30 may be a variety of computing/communication devices including, for example, a cellular phone, a personal digital assistant (PDA), a laptop, a desktop, or other types of computing/communication device that can communicate with the computing device 2-10. In alternative embodiments, the computing device 2-10 may be a local computing device that communicates directly with a user 2-20b. For these embodiments, the computing device 2-10 may be any type of handheld device such as a cellular telephone or a PDA, or other types of computing/communication devices such as a laptop computer, a desktop computer, and so forth. In certain embodiments, the computing device 2-10 may be a peer-to-peer network component device. In some embodiments, the computing device 2-10 may operate via a web 2.0 construct.

In embodiments where the computing device 2-10 is a server, the computing device 2-10 may obtain the subjective user state data 2-60 indirectly from a user 2-20a via a network interface 2-120. In alternative embodiments in which the computing device 2-10 is a local device, the subjective user state data 2-60 may be directly obtained from a user 2-20b via a user interface 2-122. As will be further described, the computing device 2-10 may acquire the objective occurrence data 2-70* from one or more sources.

For ease of illustration and explanation, the following systems and operations to be described herein will be generally described in the context of the computing device 2-10 being a network server. However, those skilled in the art will recognize that these systems and operations may also be implemented when the computing device 2-10 is a local device such as a handheld device that may communicate directly with a user 2-20b.

Assuming that the computing device 2-10 is a server, the computing device 2-10, in various implementations, may be configured to acquire subjective user state data 2-60 including data indicating at least one subjective user state 2-60a via the mobile device 2-30 and through wireless and/or wired networks 2-40. In some implementations, the subjective user state data 2-60 may further include additional data that may indicate one or more additional subjective user states (e.g., data indicating at least a second subjective user state 2-60b). In various embodiments, the data indicating the at least one subjective user state 2-60a, as well as the data indicating the at least second subjective user state 2-60b, may be in the form of blog entries, such as microblog entries, status reports (e.g., social networking status reports), electronic messages (email, text messages, instant messages, etc.) or other types of electronic messages or documents. The data indicating the at least one subjective user state 2-60a and the data indicating the at least second subjective user state 2-60b may, in some instances, indicate the same, contrasting, or completely different subjective user states. Examples of subjective user states that may be indicated by the subjective user state data 2-60 include, for example, subjective mental states of the user 2-20a (e.g., user 2-20a is sad or angry), subjective physical states of the user 2-20a (e.g., physical or physiological characteristic of the user 2-20a such as the presence or absence of a stomach ache or headache), subjective overall states of the user 2-20a (e.g., user is “well”), and/or other subjective user states that only the user 2-20a can typically indicate.

The computing device 2-10 may be further configured to acquire objective occurrence data 2-70* from one or more sources. In various embodiments, the objective occurrence data 2-70* acquired by the computing device 2-10 may include data indicative of at least one objective occurrence associated with the user 2-20a. The objective occurrence data 2-70* may additionally include, in some embodiments, data indicative of one or more additional objective occurrences associated with the user 2-20a including data indicating at least a second objective occurrence associated with the user 2-20a. In some embodiments, objective occurrence data 2-70a may be acquired from one or more third parties 2-50. Examples of third parties 2-50 include, for example, other users, a health care provider, a hospital, a place of employment, a content provider, and so forth.

In some embodiments, objective occurrence data 2-70b may be acquired from one or more sensors 2-35 for sensing or monitoring various aspects associated with the user 2-20a. For example, in some implementations, sensors 2-35 may include a global positioning system (GPS) device for determining the location of the user 2-20a or a physical activity sensor for measuring physical activities of the user 2-20a. Examples of a physical activity sensor include, for example, a pedometer for measuring physical activities of the user 2-20a. In certain implementations, the one or more sensors 2-35 may include one or more physiological sensor devices for measuring physiological characteristics of the user 2-20a. Examples of physiological sensor devices include, for example, a blood pressure monitor, a heart rate monitor, a glucometer, and so forth. In some implementations, the one or more sensors 2-35 may include one or more image capturing devices such as a video or digital camera.

In some embodiments, objective occurrence data 2-70c may be acquired from the user 2-20a via the mobile device 2-30. For these embodiments, the objective occurrence data 2-70c may be in the form of blog entries (e.g., microblog entries), status reports, or other types of electronic messages. In various implementations, the objective occurrence data 2-70c acquired from the user 2-20a may indicate, for example, activities (e.g., exercise or food or medicine intake) performed by the user 2-20a, certain physical characteristics (e.g., blood pressure or location) associated with the user 2-20a, or other aspects associated with the user 2-20a that the user 2-20a can report objectively. In still other implementations, objective occurrence data 2-70d may be acquired from a memory 2-140.

After acquiring the subjective user state data 2-60 and the objective occurrence data 2-70*, the computing device 2-10 may be configured to correlate the acquired subjective user data 2-60 with the acquired objective occurrence data 2-70* by, for example, determining whether there is a sequential relationship between the one or more subjective user states as indicated by the acquired subjective user state data 2-60 and the one or more objective occurrences indicated by the acquired objective occurrence data 2-70*.

In some embodiments, and as will be further indicated in the operations and processes to be described herein, the computing device 2-10 may be further configured to present one or more results of correlation. In various embodiments, the one or more correlation results 2-80 may be presented to the user 2-20a and/or to one or more third parties 2-50 in various forms. The one or more third parties 2-50 may be other users 2-20* such as other microbloggers, a health care provider, advertisers, and/or content providers.

As illustrated in FIG. 2-1b, computing device 2-10 may include one or more components or sub-modules. For instance, in various implementations, computing device 2-10 may include a subjective user state data acquisition module 2-102, an objective occurrence data acquisition module 2-104, a correlation module 2-106, a presentation module 2-108, a network interface 2-120, a user interface 2-122, one or more applications 2-126, and/or memory 2-140. The functional roles of these components/modules will be described in the processes and operations to be described herein.

FIG. 2-2a illustrates particular implementations of the subjective user state data acquisition module 2-102 of the computing device 2-10 of FIG. 2-1b. In brief, the subjective user state data acquisition module 2-102 may be designed to, among other things, acquire subjective user state data 2-60 including data indicating at least one subjective user state 2-60a. As further illustrated, the subjective user state data acquisition module 2-102, in various embodiments, may include a subjective user state data reception module 2-202 for receiving the subjective user state data 2-60 from a user 2-20a via the network interface 2-120 (e.g., in the case where the computing device 2-10 is a network server). Alternatively, the subjective user state data reception module 2-202 may receive the subjective user state data 2-60 directly from a user 2-20b (e.g., in the case where the computing device 2-10 is a local device) via the user interface 2-122.

In some implementations, the subjective user state data reception module 2-202 may further include a user interface data reception module 2-204, a network interface data reception module 2-206, a text entry data reception module 2-208, an audio entry data reception module 2-210, and/or an image entry data reception module 2-212. In brief, and as will be further described in the processes and operations to be described herein, the user interface data reception module 2-204 may be configured to acquire subjective user state data 2-60 via a user interface 2-122 (e.g., a display monitor, a keyboard, a touch screen, a mouse, a keypad, a microphone, a camera, and/or other interface devices) such as in the case where the computing device 2-10 is a local device to be used directly by a user 2-20b.

In contrast, the network interface data reception module 2-206 may be configured to acquire subjective user state data 2-60 via a network interface 2-120 (e.g., network interface card or NIC) such as in the case where the computing device 2-10 is a network server. The text entry data reception module 2-208 may be configured to receive data indicating at least one subjective user state 2-60a that was obtained based, at least in part, on one or more text entries provided by a user 2-20*. The audio entry data reception module 2-210 may be configured to receive data indicating at least one subjective user state 2-60a that was obtained, based, at least in part, on one or more audio entries provided by a user 2-20*. The image entry data reception module 2-212 may be configured to receive data indicating at least one subjective user state 2-60a that was obtained based, at least in part, on one or more image entries provided by a user 2-20*.

In some embodiments, the subjective user state data acquisition module 2-102 may include a subjective user state data solicitation module 2-214 for soliciting subjective user state data 2-60 from a user 2-20*. The subjective user state data solicitation module 2-214 may solicit the subjective user state data 2-60 from a user 2-20a via a network interface 2-120 (e.g., in the case where the computing device 2-10 is a network server) or from a user 2-20b via a user interface 2-122 (e.g., in the case where the computing device 2-10 is a local device used directly by a user 2-20b). The solicitation of the subjective user state data 2-60, in various embodiments, may involve requesting a user 2-20* to select one or more subjective user states from a list of alternative subjective user state options (e.g., user 2-20* can choose at least one from a choice of “I'm feeling alert,” “I'm feeling sad,” “My back is hurting,” “I have an upset stomach,” and so forth).

In some embodiments, the request to select from a list of alternative subjective user state options may simply involve requesting the user 2-20* to select one subjective user state from two contrasting and opposite subjective user state options (e.g., “I'm feeling good” or “I'm feeling bad”). The subjective user state data solicitation module 2-214 may be used in some circumstances in order to prompt a user 2-20* to provide useful data. For instance, if a user 2-20* reports a first subjective user state following the occurrence of a first objective occurrence, then the subjective user state data solicitation module 2-214 may solicit from the user 2-20* a second subjective user state following the occurrence of a second objective occurrence.

In some implementations, the subjective user state data solicitation module 2-214 may further include a transmission module 2-216 for transmitting to a user 2-20a, a request (e.g., solicitation) for a subjective user state. The request or solicitation for the subjective user state may be transmitted to the user 2-20a via a network interface 2-120 and may be in the form of an electronic message.

In some implementations, the subjective user state data solicitation module 2-214 may further include a display module 2-218 for displaying to a user 2-20b, a request (e.g., solicitation) for a subjective user state. The request or solicitation for the subjective user state may be displayed to the user 2-20b via a user interface 2-122 in the form of a text message, an audio message, or a visual message.

In various embodiments, the subjective user state data acquisition module 2-102 may include a time data acquisition module 2-220 for acquiring time and/or temporal elements associated with one or more subjective user states of a user 2-20*. For these embodiments, the time and/or temporal elements (e.g., time stamps, time interval indicators, and/or temporal relationship indicators) acquired by the time data acquisition module 2-220 may be useful for determining sequential patterns associated with subjective user states and objective occurrences as will be further described herein. In some implementations, the time data acquisition module 2-220 may include a time stamp acquisition module 2-222 for acquiring (e.g., either by receiving or generating) one or more time stamps associated with one or more subjective user states. In the same or different implementations, the time data acquisition module 2-220 may include a time interval acquisition module 2-223 for acquiring (e.g., either by receiving or generating) indications of one or more time intervals associated with one or more subjective user states. In the same or different implementations, the time data acquisition module 2-220 may include a temporal relationship acquisition module 2-224 for acquiring indications of temporal relationships between subjective user states and objective occurrence (e.g., an indication that a subjective user state occurred before, after, or at least partially concurrently with incidence of an objective occurrence).

Referring now to FIG. 2-2b illustrating particular implementations of the objective occurrence data acquisition module 2-104 of the computing device 2-10 of FIG. 2-1b. In various implementations, the objective occurrence data acquisition module 2-104 may be configured to acquire (e.g., receive, solicit, and/or retrieve from a user 2-20*, one or more third parties 2-50, one or more sensors 2-35, and/or a memory 2-140) objective occurrence data 2-70* including data indicative of one or more objective occurrences associated with a user 2-20*. In some embodiments, the objective occurrence data acquisition module 2-104 may include an objective occurrence data reception module 2-226 configured to receive (e.g., via network interface 2-120 or via user interface 2-122) objective occurrence data 2-70*.

In the same or different embodiments, the objective occurrence data acquisition module 2-104 may include a time data acquisition module 2-228 configured to acquire time and/or temporal elements associated with one or more objective occurrences associated with a user 2-20*. For these embodiments, the time and/or temporal elements (e.g., time stamps, time intervals, and/or temporal relationships) may be useful for determining sequential patterns associated with objective occurrences and subjective user states. In some implementations, the time data acquisition module 2-228 may include a time stamp acquisition module 2-230 for acquiring (e.g., either by receiving or generating) one or more time stamps associated with one or more objective occurrences associated with a user 2-20*. In the same or different implementations, the time data acquisition module 2-228 may include a time interval acquisition module 2-231 for acquiring (e.g., either by receiving or generating) indications of one or more time intervals associated with one or more objective occurrences associated with a user 2-20*. In the same or different implementations, the time data acquisition module 2-228 may include a temporal relationship acquisition module 2-232 for acquiring indications of temporal relationships between objective occurrences and subjective user states (e.g., an indication that an objective occurrence occurred before, after, or at least partially concurrently with incidence of a subjective user state).

In various embodiments, the objective occurrence data acquisition module 2-104 may include an objective occurrence data solicitation module 2-234 for soliciting objective occurrence data 2-70* from one or more sources (e.g., a user 2-20*, one or more third parties 2-50, one or more sensors 2-35, and/or other sources). In some embodiments, the objective occurrence data solicitation module 2-234 may be prompted to solicit objective occurrence data 2-70* including data indicating one or more objective occurrences in response to a reporting of one or more subjective user states or to a reporting of one or more other types of events. For example, if a user 2-20* reports that he or she is feeling ill, the objective occurrence data solicitation module 2-234 may request the user 2-20* to provide the user's blood sugar level (i.e., an objective occurrence).

Turning now to FIG. 2-2c illustrating particular implementations of the correlation module 2-106 of the computing device 2-10 of FIG. 2-1b. The correlation module 2-106 may be configured to, among other things, correlate subjective user state data 2-60 with objective occurrence data 2-70* based, at least in part, on a determination of at least one sequential pattern of at least one objective occurrence and at least one subjective user state. In various embodiments, the correlation module 2-106 may include a sequential pattern determination module 2-236 configured to determine one or more sequential patterns of one or more subjective user states and one or more objective occurrences associated with a user 2-20*.

The sequential pattern determination module 2-236, in various implementations, may include one or more sub-modules that may facilitate in the determination of one or more sequential patterns. As depicted, the one or more sub-modules that may be included in the sequential pattern determination module 2-236 may include, for example, a “within predefined time increment determination” module 2-238, a temporal relationship determination module 2-239, a subjective user state and objective occurrence time difference determination module 2-240, and/or a historical data referencing module 2-241. In brief, the within predefined time increment determination module 2-238 may be configured to determine whether at least one subjective user state of a user 2-20* occurred within a predefined time increment from an incidence of at least one objective occurrence. For example, determining whether a user 2-20* feeling “bad” (i.e., a subjective user state) occurred within ten hours (i.e., predefined time increment) of eating a large chocolate sundae (i.e., an objective occurrence). Such a process may be used in order to filter out events that are likely not related or to facilitate in determining the strength of correlation between subjective user state data 2-60 and objective occurrence data 2-70*.

The temporal relationship determination module 2-239 may be configured to determine the temporal relationships between one or more subjective user states and one or more objective occurrences. For example, this may entail determining whether a particular subjective user state (e.g., sore back) occurred before, after, or at least partially concurrently with incidence of an objective occurrence (e.g., sub-freezing temperature).

The subjective user state and objective occurrence time difference determination module 2-240 may be configured to determine the extent of time difference between the incidence of at least one subjective user state and the incidence of at least one objective occurrence. For example, determining how long after taking a particular brand of medication (e.g., objective occurrence) did a user 2-20* feel “good” (e.g., subjective user state).

The historical data referencing module 2-241 may be configured to reference historical data 2-72 in order to facilitate in determining sequential patterns. For example, in various implementations, the historical data 2-72 that may be referenced may include, for example, general population trends (e.g., people having a tendency to have a hangover after drinking or ibuprofen being more effective than aspirin for toothaches in the general population), medical information such as genetic, metabolome, or proteome information related to the user 2-20* (e.g., genetic information of the user 2-20* indicating that the user 2-20* is susceptible to a particular subjective user state in response to occurrence of a particular objective occurrence), or historical sequential patterns such as known sequential patterns of the general population or of the user 2-20* (e.g., people tending to have difficulty sleeping within five hours after consumption of coffee). In some instances, such historical data 2-72 may be useful in associating one or more subjective user states with one or more objective occurrences.

In some embodiments, the correlation module 2-106 may include a sequential pattern comparison module 2-242. As will be further described herein, the sequential pattern comparison module 2-242 may be configured to compare multiple sequential patterns with each other to determine, for example, whether the sequential patterns at least substantially match each other or to determine whether the sequential patterns are contrasting sequential patterns.

As depicted in FIG. 2-2c, in various implementations, the sequential pattern comparison module 2-242 may further include one or more sub-modules that may be employed in order to, for example, facilitate in the comparison of different sequential patterns. For example, in various implementations, the sequential pattern comparison module 2-242 may include one or more of a subjective user state equivalence determination module 2-243, an objective occurrence equivalence determination module 2-244, a subjective user state contrast determination module 2-245, an objective occurrence contrast determination module 2-246, a temporal relationship comparison module 2-247, and/or an extent of time difference comparison module 2-248.

The subjective user state equivalence determination module 2-243 may be configured to determine whether subjective user states associated with different sequential patterns are equivalent. For example, the subjective user state equivalence determination module 2-243 determining whether a first subjective user state of a first sequential pattern is equivalent to a second subjective user state of a second sequential pattern. For instance, suppose a user 2-20* reports that on Monday he had a stomach ache (e.g., first subjective user state) after eating at a particular restaurant (e.g., a first objective occurrence), and suppose further that the user 2-20* again reports having a stomach ache (e.g., a second subjective user state) after eating at the same restaurant (e.g., a second objective occurrence) on Tuesday, then the subjective user state equivalence determination module 2-243 may be employed in order to compare the first subjective user state (e.g., stomach ache) with the second subjective user state (e.g., stomach ache) to determine whether they are equivalent.

In contrast, the objective occurrence equivalence determination module 2-244 may be configured to determine whether objective occurrences of different sequential patterns are equivalent. For example, the objective occurrence equivalence determination module 2-244 determining whether a first objective occurrence of a first sequential pattern is equivalent to a second objective occurrence of a second sequential pattern. For instance, for the above example the objective occurrence equivalence determination module 2-244 may compare eating at the particular restaurant on Monday (e.g., first objective occurrence) with eating at the same restaurant on Tuesday (e.g., second objective occurrence) in order to determine whether the first objective occurrence is equivalent to the second objective occurrence.

In some implementations, the sequential pattern comparison module 2-242 may include a subjective user state contrast determination module 2-245 that may be configured to determine whether subjective user states associated with different sequential patterns are contrasting subjective user states. For example, the subjective user state contrast determination module 2-245 may determine whether a first subjective user state of a first sequential pattern is a contrasting subjective user state from a second subjective user state of a second sequential pattern. For instance, suppose a user 2-20* reports that he felt very “good” (e.g., first subjective user state) after jogging for an hour (e.g., first objective occurrence) on Monday, but reports that he felt “bad” (e.g., second subjective user state) when he did not exercise (e.g., second objective occurrence) on Tuesday, then the subjective user state contrast determination module 2-245 may compare the first subjective user state (e.g., feeling good) with the second subjective user state (e.g., feeling bad) to determine that they are contrasting subjective user states.

In some implementations, the sequential pattern comparison module 2-242 may include an objective occurrence contrast determination module 2-246 that may be configured to determine whether objective occurrences of different sequential patterns are contrasting objective occurrences. For example, the objective occurrence contrast determination module 2-246 may determine whether a first objective occurrence of a first sequential pattern is a contrasting objective occurrence from a second objective occurrence of a second sequential pattern. For instance, for the above example, the objective occurrence contrast determination module 2-246 may compare the “jogging” on Monday (e.g., first objective occurrence) with the “no jogging” on Tuesday (e.g., second objective occurrence) in order to determine whether the first objective occurrence is a contrasting objective occurrence from the second objective occurrence. Based on the contrast determination, an inference may be made that the user 2-20* may feel better by jogging rather than by not jogging at all.

In some embodiments, the sequential pattern comparison module 2-242 may include a temporal relationship comparison module 2-247 that may be configured to make comparisons between different temporal relationships of different sequential patterns. For example, the temporal relationship comparison module 2-247 may compare a first temporal relationship between a first subjective user state and a first objective occurrence of a first sequential pattern with a second temporal relationship between a second subjective user state and a second objective occurrence of a second sequential pattern in order to determine whether the first temporal relationship at least substantially matches the second temporal relationship.

For example, suppose in the above example the user 2-20* eating at the particular restaurant (e.g., first objective occurrence) and the subsequent stomach ache (e.g., first subjective user state) on Monday represents a first sequential pattern while the user 2-20* eating at the same restaurant (e.g., second objective occurrence) and the subsequent stomach ache (e.g., second subjective user state) on Tuesday represents a second sequential pattern. In this example, the occurrence of the stomach ache after (rather than before or concurrently) eating at the particular restaurant on Monday represents a first temporal relationship associated with the first sequential pattern while the occurrence of a second stomach ache after (rather than before or concurrently) eating at the same restaurant on Tuesday represents a second temporal relationship associated with the second sequential pattern. Under such circumstances, the temporal relationship comparison module 2-247 may compare the first temporal relationship to the second temporal relationship in order to determine whether the first temporal relationship and the second temporal relationship at least substantially match (e.g., stomachaches in both temporal relationships occurring after eating at the restaurant). Such a match may result in the inference that a stomach ache is associated with eating at the particular restaurant.

In some implementations, the sequential pattern comparison module 2-242 may include an extent of time difference comparison module 2-248 that may be configured to compare the extent of time differences between incidences of subjective user states and incidences of objective occurrences of different sequential patterns. For example, the extent of time difference comparison module 2-248 may compare the extent of time difference between incidence of a first subjective user state and incidence of a first objective occurrence of a first sequential pattern with the extent of time difference between incidence of a second subjective user state and incidence of a second objective occurrence of a second sequential pattern. In some implementations, the comparisons may be made in order to determine that the extent of time differences of the different sequential patterns at least substantially or proximately match.

In some embodiments, the correlation module 2-106 may include a strength of correlation determination module 2-250 for determining a strength of correlation between subjective user state data 2-60 and objective occurrence data 2-70* associated with a user 2-20*. In some implementations, the strength of correlation may be determined based, at least in part, on the results provided by the other sub-modules of the correlation module 2-106 (e.g., the sequential pattern determination module 2-236, the sequential pattern comparison module 2-242, and their sub-modules).

FIG. 2-2d illustrates particular implementations of the presentation module 2-108 of the computing device 2-10 of FIG. 2-1b. In various implementations, the presentation module 2-108 may be configured to present one or more results of the correlation operations performed by the correlation module 2-106. This may involve presenting the one or more results in different forms. For example, in some implementations this may entail the presentation module 2-108 presenting to the user 2-20* an indication of a sequential relationship between a subjective user state and an objective occurrence associated with the user 2-20* (e.g., “whenever you eat a banana, you have a stomach ache). In alternative implementations, other ways of presenting the results of the correlation may be employed. For example, in various alternative implementations, a notification may be provided to notify past tendencies or patterns associated with a user 2-20*. In some implementations, a notification of a possible future outcome may be provided. In other implementations, a recommendation for a future course of action based on past patterns may be provided. These and other ways of presenting the correlation results will be described in the processes and operations to be described herein.

In various implementations, the presentation module 2-108 may include a transmission module 2-252 for transmitting one or more results of the correlation performed by the correlation module 2-106. For example, in the case where the computing device 2-10 is a server, the transmission module 2-252 may be configured to transmit to the user 2-20a or a third party 2-50 the one or more results of the correlation performed by the correlation module 2-106 via a network interface 2-120.

In the same or different implementations, the presentation module 2-108 may include a display module 2-254 for displaying the one or more results of the correlation operations performed by the correlation module 2-106. For example, in the case where the computing device 2-10 is a local device, the display module 2-254 may be configured to display to the user 2-20b the one or more results of the correlation performed by the correlation module 2-106 via a user interface 2-122.

In some implementations, the presentation module 2-108 may include a sequential relationship presentation module 2-256 configured to present an indication of a sequential relationship between at least one subjective user state of a user 2-20* and at least one objective occurrence associated with the user 2-20*. In some implementations, the presentation module 2-108 may include a prediction presentation module 2-258 configured to present a prediction of a future subjective user state of a user 2-20* resulting from a future objective occurrence associated with the user 2-20*. In the same or different implementations, the prediction presentation module 2-258 may also be designed to present a prediction of a future subjective user state of a user 2-20* resulting from a past objective occurrence associated with the user 2-20*. In some implementations, the presentation module 2-108 may include a past presentation module 2-260 that is designed to present a past subjective user state of a user 2-20* in connection with a past objective occurrence associated with the user 2-20*.

In some implementations, the presentation module 2-108 may include a recommendation module 2-262 that is configured to present a recommendation for a future action based, at least in part, on the results of a correlation of subjective user state data 2-60 with objective occurrence data 2-70* performed by the correlation module 2-106. In certain implementations, the recommendation module 2-262 may further include a justification module 2-264 for presenting a justification for the recommendation presented by the recommendation module 2-262. In some implementations, the presentation module 2-108 may include a strength of correlation presentation module 2-266 for presenting an indication of a strength of correlation between subjective user state data 2-60 and objective occurrence data 2-70*.

As will be further described herein, in some embodiments, the presentation module 2-108 may be prompted to present the one or more results of a correlation operation performed by the correlation module 2-106 in response to a reporting of one or more events, objective occurrences, and/or subjective user states.

As briefly described earlier, in various embodiments, the computing device 2-10 may include a network interface 2-120 that may facilitate in communicating with a user 2-20a and/or one or more third parties 2-50. For example, in embodiments whereby the computing device 2-10 is a server, the computing device 2-10 may include a network interface 2-120 that may be configured to receive from the user 2-20a subjective user state data 2-60. In some embodiments, objective occurrence data 2-70a, 2-70b, or 2-70c may also be received through the network interface 2-120. Examples of a network interface 2-120 includes, for example, a network interface card (NIC).

The computing device 2-10, in various embodiments, may also include a memory 2-140 for storing various data. For example, in some embodiments, memory 2-140 may be employed in order to store subjective user state data 2-61 of a user 2-20* that may indicate one or more past subjective user states of the user 2-20* and objective occurrence data 2-70* associated with the user 2-20* that may indicate one or more past objective occurrences. In some embodiments, memory 2-140 may store historical data 2-72 such as historical medical data of a user 2-20* (e.g., genetic, metoblome, proteome information), population trends, historical sequential patterns derived from general population, and so forth.

In various embodiments, the computing device 2-10 may include a user interface 2-122 to communicate directly with a user 2-20b. For example, in embodiments in which the computing device 2-10 is a local device, the user interface 2-122 may be configured to directly receive from the user 2-20b subjective user state data 2-60. The user interface 2-122 may include, for example, one or more of a display monitor, a touch screen, a key board, a key pad, a mouse, an audio system, an imaging system including a digital or video camera, and/or other user interface devices.

FIG. 2-2e illustrates particular implementations of the one or more applications 2-126 of FIG. 2-1b. For these implementations, the one or more applications 2-126 may include, for example, communication applications such as a text messaging application and/or an audio messaging application including a voice recognition system application. In some implementations, the one or more applications 2-126 may include a web 2.0 application 2-266 to facilitate communication via, for example, the World Wide Web. The functional roles of the various components, modules, and sub-modules of the computing device 2-10 presented thus far will be described in greater detail with respect to the processes and operations to be described herein. Note that the subjective user state data 2-60 may be in a variety of forms including, for example, text messages (e.g., blog entries, microblog entries, instant messages, text email messages, and so forth), audio messages, and/or images (e.g., an image capturing user's facial expression or gestures).

FIG. 2-3 illustrates an operational flow 2-300 representing example operations related to acquisition and correlation of subjective user state data 2-60 and objective occurrence data 2-70* in accordance with various embodiments. In some embodiments, the operational flow 2-300 may be executed by, for example, the computing device 2-10 of FIG. 2-1b.

In FIG. 2-3 and in the following figures that include various examples of operational flows, discussions and explanations may be provided with respect to the above-described exemplary environment of FIGS. 2-1a and 2-1b, and/or with respect to other examples (e.g., as provided in FIGS. 2-2a to 2-2e) and contexts. However, it should be understood that the operational flows may be executed in a number of other environments and contexts, and/or in modified versions of FIGS. 2-1a, 2-1b, and 2-2a to 2-2e. Also, although the various operational flows are presented in the sequence(s) illustrated, it should be understood that the various operations may be performed in other orders than those which are illustrated, or may be performed concurrently.

Further, in FIG. 2-3 and in following figures, various operations may be depicted in a box-within-a-box manner. Such depictions may indicate that an operation in an internal box may comprise an optional example embodiment of the operational step illustrated in one or more external boxes. However, it should be understood that internal box operations may be viewed as independent operations separate from any associated external boxes and may be performed in any sequence with respect to all other illustrated operations, or may be performed concurrently.

In any event, after a start operation, the operational flow 2-300 may move to a subjective user state data acquisition operation 2-302 for acquiring subjective user state data including data indicating at least one subjective user state associated with a user. For instance, the subjective user state data acquisition module 2-102 of the computing device 2-10 of FIG. 2-1b acquiring (e.g., receiving via network interface 2-120 or via user interface 2-122) subjective user state data 2-60 including data indicating at least one subjective user state 2-60a (e.g., a subjective mental state, a subjective physical state, or a subjective overall state) associated with a user 2-20*.

Operational flow 2-300 may also include an objective occurrence data acquisition operation 2-304 for acquiring objective occurrence data including data indicating at least one objective occurrence associated with the user. For instance, the objective occurrence data acquisition module 2-104 of the computing device 2-10 acquiring, via the network interface 2-120 or via the user interface 2-122, objective occurrence data 2-70* including data indicating at least one objective occurrence (e.g., ingestion of a food, medicine, or nutraceutical) associated with the user 2-20*. Note that, and as those skilled in the art will recognize, the subjective user state data acquisition operation 2-302 does not have to be performed prior to the objective occurrence data acquisition operation 2-304 and may be performed subsequent to the performance of the objective occurrence data acquisition operation 2-304 or may be performed concurrently with the objective occurrence data acquisition operation 2-304.

Operational flow 2-300 may further include a correlation operation 2-306 for correlating the subjective user state data with the objective occurrence data based, at least in part, on a determination of at least one sequential pattern associated with the at least one subjective user state and the at least one objective occurrence. For instance, the correlation module 2-106 of the computing device 2-10 correlating the subjective user state data 2-60 with the objective occurrence data 2-70* based, at least in part, on a determination of at least one sequential pattern (e.g., time sequential pattern) associated with the at least one subjective user state (e.g., user feeling “tired”) and the at least one objective occurrence (e.g., high blood sugar level).

Finally, the operational flow 2-300 may include a presentation operation 2-308 for presenting one or more results of the correlating. For instance, the presentation module 2-108 of the computing device 2-10 presenting, via the network interface 2-120 or via the user interface 2-122, one or more results (e.g., in the form of a recommendation for a future action or in the form of a notification of a past event) of the correlating performed by the correlation operation 2-306.

In various implementations, the subjective user state data acquisition operation 2-302 may include one or more additional operations as illustrated in FIGS. 2-4a, 2-4b, 2-4c, 2-4d, and 2-4e. For example, in some implementations the subjective user state data acquisition operation 2-302 may include a reception operation 2-402 for receiving the subjective user state data as depicted in FIGS. 2-4a and 2-4b. For instance, the subjective user state data reception module 2-202 of the computing device 2-10 receiving (e.g., via network interface 2-120 or via the user interface 2-122) the subjective user state data 2-60.

The reception operation 2-402 may, in turn, further include one or more additional operations. For example, in some implementations, the reception operation 2-402 may include an operation 2-404 for receiving the subjective user state data via a user interface as depicted in FIG. 2-4a. For instance, the user interface data reception module 2-204 of the computing device 2-10 receiving the subjective user state data 2-60 via a user interface 2-122 (e.g., a keypad, a keyboard, a display monitor, a touchscreen, a mouse, an audio system including a microphone, an image capturing system including a video or digital camera, and/or other interface devices).

In some implementations, the reception operation 2-402 may include an operation 2-406 for receiving the subjective user state data via a network interface as depicted in FIG. 2-4a. For instance, the network interface data reception module 2-206 of the computing device 2-10 receiving the subjective user state data 2-60 via a network interface 2-120 (e.g., a NIC).

In various implementations, operation 2-406 may further include one or more operations. For example, in some implementations operation 2-406 may include an operation 2-408 for receiving data indicating the at least one subjective user state via an electronic message generated by the user as depicted in FIG. 2-4a. For instance, the network interface data reception module 2-206 of the computing device 2-10 receiving data indicating the one subjective user state 2-60a (e.g., subjective mental state such as feelings of happiness, sadness, anger, frustration, mental fatigue, drowsiness, alertness, and so forth) via an electronic message (e.g., email, IM, or text message) generated by the user 2-20a.

In some implementations, operation 2-406 may include an operation 2-410 for receiving data indicating the at least one subjective user state via a blog entry generated by the user as depicted in FIG. 2-4a. For instance, the network interface data reception module 2-206 of the computing device 2-10 receiving data indicating the at least one subjective user state 2-60a (e.g., subjective physical state such as physical exhaustion, physical pain such as back pain or toothache, upset stomach, blurry vision, and so forth) via a blog entry such as a microblog entry generated by the user 2-20a.

In some implementations, operation 2-406 may include an operation 2-412 for receiving data indicating the at least one subjective user state via a status report generated by the user as depicted in FIG. 2-4a. For instance, the network interface data reception module 2-206 of the computing device 2-10 receiving data indicating the at least one subjective user state 2-60a (e.g., subjective overall state of the user 2-20* such as good, bad, well, exhausted, and so forth) via a status report (e.g., social network status report) generated by the user 2-20a.

In some implementations, the reception operation 2-402 may include an operation 2-414 for receiving subjective user state data including data indicating at least one subjective user state specified by a selection made by the user, the selection being a selection of a subjective user state from a plurality of alternative subjective user states as depicted in FIG. 2-4a. For instance, the subjective user state data reception module 2-202 of the computing device 2-10 receiving subjective user state data 2-60 including data indicating at least one subjective user state specified by a selection (e.g., via mobile device 2-30 or via user interface 2-122) made by the user 2-20*, the selection being a selection of a subjective user state from a plurality of alternative subjective user states (e.g., as indicated by the mobile device 2-30 or by the user interface 2-122).

Operation 2-414 may include one or more additional operations in various alternative implementations. For example, in some implementations, operation 2-414 may include an operation 2-416 for receiving subjective user state data including data indicating at least one subjective user state specified by a selection made by the user, the selection being a selection of a subjective user state from two alternative contrasting subjective user states as depicted in FIG. 2-4a. For instance, the subjective user state data reception module 2-202 of the computing device 2-10 receiving subjective user state data 2-60 including data indicating at least one subjective user state 2-60a specified (e.g., via the mobile device 2-30 or via the user interface 2-122) by a selection made by the user 2-20*, the selection being a selection of a subjective user state from two alternative contrasting subjective user states (e.g., user in pain or not in pain).

In some implementations, operation 2-414 may include an operation 2-417 for receiving the selection via a network interface as depicted in FIG. 2-4a. For instance, the network interface data reception module 2-206 of the computing device 2-10 receiving the selection of a subjective user state (e.g., a subjective mental state, a subjective physical state, or a subjective overall state) via a network interface 2-120.

In some implementations, operation 2-414 may include an operation 2-418 for receiving the selection via user interface as depicted in FIG. 2-4a. For instance, the user interface data reception module 2-204 of the computing device 2-10 receiving the selection of a subjective user state (e.g., a subjective mental state, a subjective physical state, or a subjective overall state) via a user interface 2-122.

In some implementations, the reception operation 2-402 may include an operation 2-420 for receiving data indicating at least one subjective user state associated with the user that was obtained based, at least in part, on a text entry provided by the user as depicted in FIG. 2-4b. For instance, the text entry data reception module 2-208 of the computing device 2-10 receiving data indicating at least one subjective user state 2-60a (e.g., a subjective mental state, a subjective physical state, or a subjective overall state) associated with the user 2-20* that was obtained based, at least in part, on a text entry provided by the user 2-20* (e.g., a text message provided by the user 2-20* via the mobile device 2-10 or via the user interface 2-122).

In some implementations, the reception operation 2-402 may include an operation 2-422 for receiving data indicating at least one subjective user state associated with the user that was obtained based, at least in part, on an audio entry provided by the user as depicted in FIG. 2-4b. For instance, the audio entry data reception module 2-210 of the computing device 2-10 receiving data indicating at least one subjective user state 2-60a (e.g., a subjective mental state, a subjective physical state, or a subjective overall state) associated with the user 2-20* that was obtained based, at least in part, on an audio entry provided by the user 2-20* (e.g., audio recording made via the mobile device 2-30 or via the user interface 2-122).

In some implementations, the reception operation 2-402 may include an operation 2-424 for receiving data indicating at least one subjective user state associated with the user that was obtained based, at least in part, on an image entry provided by the user as depicted in FIG. 2-4b. For instance, the image entry data reception module 2-212 of the computing device 2-10 receiving data indicating at least one subjective user state 2-60a (e.g., a subjective mental state, a subjective physical state, or a subjective overall state) associated with the user 2-20* that was obtained based, at least in part, on an image entry provided by the user 2-20* (e.g., one or more images recorded via the mobile device 2-30 or via the user interface 2-122).

Operation 2-424 may further include one or more additional operations in various alternative implementations. For example, in some implementations, operation 2-424 may include an operation 2-426 for receiving data indicating at least one subjective user state associated with the user that was obtained based, at least in part, on an image entry showing a gesture made by the user as depicted in FIG. 2-4b. For instance, the image entry data reception module 2-212 of the computing device 2-10 receiving data indicating at least one subjective user state 2-60a (e.g., a subjective user state such as “user is good” or “user is not good”) associated with the user 2-20* that was obtained based, at least in part, on an image entry showing a gesture (e.g., a thumb up or a thumb down) made by the user 2-20*.

In some implementations, operation 2-424 may include an operation 2-428 for receiving data indicating at least one subjective user state associated with the user that was obtained based, at least in part, on an image entry showing an expression made by the user as depicted in FIG. 2-4b. For instance, the image entry data reception module 2-212 of the computing device 2-10 receiving data indicating at least one subjective user state 2-60a (e.g., a subjective mental state such as happiness or sadness) associated with the user 2-20* that was obtained based, at least in part, on an image entry showing an expression (e.g., a smile or a frown expression) made by the user 2-20*.

In some implementations, the reception operation 2-402 may include an operation 2-430 for receiving data indicating at least one subjective user state associated with the user that was obtained based, at least in part, on data provided through user interaction with a user interface as depicted in FIG. 2-4b. For instance, the subjective user state data reception module 2-202 of the computing device 2-10 receiving data indicating at least one subjective user state 2-60a associated with the user 2-20* that was obtained based, at least in part, on data provided through user interaction (e.g., user 2-20* selecting one subjective user state from a plurality of alternative subjective user states) with a user interface 2-122 of the computing device 2-10 or with a user interface 2-122 of the mobile device 2-30.

In various implementations, the subjective user state data acquisition operation 2-302 may include an operation 2-432 for acquiring data indicating at least one subjective mental state of the user as depicted in FIG. 2-4b. For instance, the subjective user state data acquisition module 2-102 of the computing device 2-10 acquiring (e.g., via network interface 2-120 or via user interface 2-122) data indicating at least one subjective mental state (e.g., sadness, happiness, alertness or lack of alertness, anger, frustration, envy, hatred, disgust, and so forth) of the user 2-20*.

In some implementations, operation 2-432 may further include an operation 2-434 for acquiring data indicating at least a level of the one subjective mental state of the user as depicted in FIG. 2-4b. For instance, the subjective user state data acquisition module 2-102 of the computing device 2-10 acquiring data indicating at least a level of the one subjective mental state (e.g., extreme sadness or slight sadness) of the user 2-20*.

In various implementations, the subjective user state data acquisition operation 2-302 may include an operation 2-436 for acquiring data indicating at least one subjective physical state of the user as depicted in FIG. 2-4b. For instance, the subjective user state data acquisition module 2-102 of the computing device 2-10 acquiring (e.g., via network interface 2-120 or via user interface 2-122) data indicating at least one subjective physical state (e.g., blurry vision, physical pain such as backache or headache, upset stomach, physical exhaustion, and so forth) of the user 2-20*.

In some implementations, operation 2-436 may further include an operation 2-438 for acquiring data indicating at least a level of the one subjective physical state of the user as depicted in FIG. 2-4b. For instance, the subjective user state data acquisition module 2-102 of the computing device 2-10 acquiring data indicating at least a level of the one subjective physical state (e.g., a slight headache or a severe headache) of the user 2-20*.

In various implementations, the subjective user state data acquisition operation 2-302 may include an operation 2-440 for acquiring data indicating at least one subjective overall state of the user as depicted in FIG. 2-4c. For instance, the subjective user state data acquisition module 2-102 of the computing device 2-10 acquiring (e.g., via network interface 2-120 or via user interface 2-122) data indicating at least one subjective overall state (e.g., good, bad, wellness, hangover, fatigue, nausea, and so forth) of the user 2-20*. Note that a subjective overall state, as used herein, may be in reference to any subjective user state that may not fit neatly into the categories of subjective mental state or subjective physical state.

In some implementations, operation 2-440 may further include an operation 2-442 for acquiring data indicating at least a level of the one subjective overall state of the user as depicted in FIG. 2-4c. For instance, the subjective user state data acquisition module 2-102 of the computing device 2-10 acquiring data indicating at least a level of the one subjective overall state (e.g., a very bad hangover) of the user 2-20*.

In various implementations, the subjective user state data acquisition operation 2-302 may include an operation 2-444 for acquiring subjective user state data including data indicating at least a second subjective user state associated with the user as depicted in FIG. 2-4c. For instance, the subjective user state data acquisition module 2-102 of the computing device 2-10 acquiring subjective user state data 2-60 including data indicating at least a second subjective user state 2-60b (e.g., a subjective mental state, a subjective physical state, or a subjective overall state) associated with the user 2-20*.

In various alternative implementations, operation 2-444 may include one or more additional operations. For example, in some implementations, operation 2-444 includes an operation 2-446 for acquiring subjective user state data including data indicating at least a second subjective user state that is equivalent to the at least one subjective user state as depicted in FIG. 2-4c. For instance, the subjective user state data acquisition module 2-102 of the computing device 2-10 acquiring (e.g., via network interface 2-120 or via user interface 2-122) subjective user state data 2-60 including data indicating at least a second subjective user state 2-60b (e.g., anger) that is equivalent to the at least one subjective user state (e.g., anger).

In some implementations, operation 2-446 may further include an operation 2-448 for acquiring subjective user state data including data indicating at least a second subjective user state that is at least proximately equivalent in meaning to the at least one subjective user state as depicted in FIG. 2-4c. For instance, the subjective user state data acquisition module 2-102 of the computing device 2-10 acquiring subjective user state data 2-60 including data indicating at least a second subjective user state 2-60b (e.g., rage or fury) that is at least proximately equivalent in meaning to the at least one subjective user state (e.g., anger).

In some implementations, operation 2-444 includes an operation 2-450 for acquiring subjective user state data including data indicating at least a second subjective user state that is proximately equivalent to the at least one subjective user state as depicted in FIG. 2-4c. For instance, the subjective user state data acquisition module 2-102 of the computing device 2-10 acquiring subjective user state data 2-60 including data indicating at least a second subjective user state 2-60b (e.g., feeling very nauseous) that is proximately equivalent to the at least one subjective user state (e.g., feeling extremely nauseous).

In some implementations, operation 2-444 includes an operation 2-451 for acquiring subjective user state data including data indicating at least a second subjective user state that is a contrasting subjective user state from the at least one subjective user state as depicted in FIG. 2-4c. For instance, the subjective user state data acquisition module 2-102 of the computing device 2-10 acquiring subjective user state data 2-60 including data indicating at least a second subjective user state 2-60b (e.g., feeling very nauseous) that is a contrasting subjective user state from the at least one subjective user state (e.g., feeling slightly nauseous or feeling not nauseous at all).

In some implementations, operation 2-444 includes an operation 2-452 for acquiring subjective user state data including data indicating at least a second subjective user state that references the at least one subjective user state as depicted in FIG. 2-4c. For instance, the subjective user state data acquisition module 2-102 of the computing device 2-10 acquiring subjective user state data 2-60 including data indicating at least a second subjective user state 2-60b that references the at least one subjective user state (e.g., “I feel as good as yesterday” or “I am more tired than yesterday”).

In some implementations, operation 2-452 may further include an operation 2-453 for acquiring subjective user state data including data indicating at least a second subjective user state that is one of modification, extension, improvement, or regression of the at least one subjective user state as depicted in FIG. 2-4c. For instance, the subjective user state data acquisition module 2-102 of the computing device 2-10 acquiring subjective user state data 2-60 including data indicating at least a second subjective user state 2-60b that is one of a modification (e.g., “my headache from yesterday has turned into a migraine”), extension (e.g., “I still have my backache from yesterday”), improvement (e.g., “I feel better than yesterday”), or regression (e.g., “I feel more tired than yesterday”) of the at least one subjective user state.

In some implementations the subjective user state data acquisition operation 2-302 of FIG. 2-3 may include an operation 2-454 for acquiring a time stamp associated with the at least one subjective user state as depicted in FIG. 2-4d. For instance, the time stamp acquisition module 2-222 of the computing device 2-10 acquiring (e.g., via the network interface 2-120 or via the user interface 2-122 as provided by the user 2-20* or by automatically generating) a time stamp (e.g., 10 PM Aug. 4, 2009) associated with the at least one subjective user state.

Operation 2-454 may further include, in various implementations, an operation 2-455 for acquiring another time stamp associated with a second subjective user state indicated by the subjective user state data as depicted in FIG. 2-4d. For instance, the time stamp acquisition module 2-222 of the computing device 2-10 acquiring (e.g., via the network interface 2-120 or via the user interface 2-122 as provided by the user 2-20* or by automatically generating) another time stamp (e.g., 8 PM Aug. 12, 2009) associated with a second subjective user state indicated by the subjective user state data 2-60.

In some implementations the subjective user state data acquisition operation 2-302 may include an operation 2-456 for acquiring an indication of a time interval associated with the at least one subjective user state as depicted in FIG. 2-4d. For instance, the time interval acquisition module 2-223 of the computing device 2-10 acquiring (e.g., via the network interface 2-120 or via the user interface 2-122 as provided by the user 2-20* or by automatically generating) an indication of a time interval (e.g., 8 AM to 10 AM Jul. 24, 2009) associated with the at least one subjective user state.

Operation 2-456 may further include, in various implementations, an operation 2-457 for acquiring another indication of another time interval associated with a second subjective user state indicated by the subjective user state data as depicted in FIG. 2-4d. For instance, the time interval acquisition module 2-223 of the computing device 2-10 acquiring (e.g., via the network interface 2-120 or via the user interface 2-122 as provided by the user 2-20* or by automatically generating) another indication of another time interval (e.g., 2 PM to 8 PM Jul. 24, 2009) associated with a second subjective user state indicated by the subjective user state data 2-60.

In some implementations the subjective user state data acquisition operation 2-302 may include an operation 2-458 for acquiring an indication of a temporal relationship between the at least one subjective user state and the at least one objective occurrence as depicted in FIG. 2-4d. For instance, the temporal relationship acquisition module 2-224 of the computing device 2-10 acquiring (e.g., via the network interface 2-120 or via the user interface 2-122 as provided by the user 2-20* or by automatically generating) an indication of a temporal relationship between the at least one subjective user state (e.g., easing of a headache) and the at least one objective occurrence (e.g., ingestion of aspirin). For example, acquiring an indication that a user's headache eased after taking an aspirin.

Operation 2-458 may further include, in various implementations, an operation 2-459 for acquiring an indication of a temporal relationship between the at least one subjective user state and a second subjective user state indicated by the subjective user state data as depicted in FIG. 2-4d. For instance, the temporal relationship acquisition module 2-224 of the computing device 2-10 acquiring (e.g., via the network interface 2-120 or via the user interface 2-122 as provided by the user 2-20* or by automatically generating) an indication of a temporal relationship between the at least one subjective user state (e.g., tired) and a second subjective user state (e.g., energetic) indicated by the subjective user state data 2-60. For example, acquiring an indication that a user 2-20* felt tired before feeling energetic, or an indication that the user 2-20* felt energetic after feeling tired.

In some implementations the subjective user state data acquisition operation 2-302 may include an operation 2-460 for soliciting from the user the at least one subjective user state as depicted in FIG. 2-4d. For instance, the subjective user state data solicitation module 2-214 of the computing device 2-10 soliciting (e.g., via an inquiry to the user 2-20* to provide a subjective user state) from the user 2-20* the at least one subjective user state. In some implementations, the solicitation of the at least one subjective user state may involve requesting the user 2-20* to select at least one subjective user state from a plurality of alternative subjective user states.

Operation 2-460 may further include, in some implementations, an operation 2-462 for transmitting to the user a request for a subjective user state as depicted in FIG. 2-4d. For instance, the transmission module 2-216 of the computing device 2-10 transmitting (e.g., via the wireless and/or wired network 2-40) to the user 2-20* a request for a subjective user state such as the case when the computing device 2-10 is a server. Alternatively, such a request may be displayed via a user interface 2-122 in cases where, for example, the computing device 2-10 is a local device such as a handheld device.

In some implementations the subjective user state data acquisition operation 2-302 may include an operation 2-463 for acquiring the subjective user state data at a server as depicted in FIG. 2-4d. For instance, when the computing device 2-10 is a network server and is acquiring the subjective user state data 2-60.

In some implementations the subjective user state data acquisition operation 2-302 may include an operation 2-464 for acquiring the subjective user state data at a handheld device as depicted in FIG. 2-4d. For instance, when the computing device 2-10 is a handheld device such as a mobile phone or a PDA and is acquiring the subjective user state data 2-60.

In some implementations the subjective user state data acquisition operation 2-302 may include an operation 2-466 for acquiring the subjective user state data at a peer-to-peer network component device as depicted in FIG. 2-4d. For instance, when the computing device 2-10 is a peer-to-peer network component device and is acquiring the subjective user state data 2-60.

In some implementations the subjective user state data acquisition operation 2-302 may include an operation 2-468 for acquiring the subjective user state data via a Web 2.0 construct as depicted in FIG. 2-4d. For instance, when the computing device 2-10 employs a Web 2.0 application in order to acquire the subjective user state data 2-60.

In some implementations the subjective user state data acquisition operation 2-302 may include an operation 2-470 for acquiring data indicating one subjective user state that occurred at least partially concurrently with an incidence of one objective occurrence associated with the user as depicted in FIG. 2-4e. For instance, the subjective user state data acquisition module 2-102 of the computing device 2-10 acquiring (e.g., via a network interface 2-120 or a user interface 2-122) data indicating one subjective user state (e.g., feeling aggravated) that occurred at least partially concurrently with an incidence of one objective occurrence (e.g., in-laws visiting) associated with the user 2-20*.

In some implementations the subjective user state data acquisition operation 2-302 may include an operation 2-472 for acquiring data indicating one subjective user state that occurred prior to an incidence of one objective occurrence associated with the user as depicted in FIG. 2-4e. For instance, the subjective user state data acquisition module 2-102 of the computing device 2-10 acquiring (e.g., via a network interface 2-120 or a user interface 2-122) data indicating one subjective user state (e.g., fear) that occurred prior to an incidence of one objective occurrence (e.g., meeting with the boss) associated with the user 2-20*.

In some implementations the subjective user state data acquisition operation 2-302 may include an operation 2-474 for acquiring data indicating one subjective user state that occurred subsequent to an incidence of one objective occurrence associated with the user as depicted in FIG. 2-4e. For instance, the subjective user state data acquisition module 2-102 of the computing device 2-10 acquiring (e.g., via a network interface 2-120 or a user interface 2-122) data indicating one subjective user state (e.g., easing of a headache) that occurred subsequent to an incidence of one objective occurrence (e.g., consuming a particular brand of aspirin) associated with the user 2-20*.

In some implementations the subjective user state data acquisition operation 2-302 may include an operation 2-476 for acquiring data that indicates one subjective user state that occurred within a predefined time period of an incidence of one objective occurrence associated with the user as depicted in FIG. 2-4e. For instance, the subjective user state data acquisition module 2-102 of the computing device 2-10 acquiring (e.g., via a network interface 2-120 or a user interface 2-122) data indicating one subjective user state (e.g., easing of a backache) that occurred within a predefined time period (e.g., three hours) of an incidence of one objective occurrence (e.g., ingestion of a dose of ibuprofen) associated with the user 2-20*.

Referring back to FIG. 2-3, the objective occurrence data acquisition operation 2-304 in various embodiments may include one or more additional operations as illustrated in FIGS. 2-5a to 2-5k. For example, in some implementations, the objective occurrence data acquisition operation 2-304 may include a reception operation 2-500 for receiving the objective occurrence data as depicted in FIG. 2-5a. For instance, the objective occurrence data reception module 2-226 (see FIG. 2-2b) of the computing device 2-10 receiving (e.g., via the network interface 2-120 or via the user interface 2-122) the objective occurrence data 2-70*.

The reception operation 2-500 in various implementations may include one or more additional operations. For example, in some implementations the reception operation 2-500 may include an operation 2-501 for receiving the objective occurrence data from at least one of a wireless network or a wired network as depicted in FIG. 2-5a. For instance, the objective occurrence data reception module 2-226 of the computing device 2-10 receiving (e.g., via the network interface 2-120) the objective occurrence data 2-70* from at least one of a wireless network or a wired network.

In some implementations, the reception operation 2-500 may include an operation 2-502 for receiving the objective occurrence data via one or more blog entries as depicted in FIG. 2-5a. For instance, the objective occurrence data reception module 2-226 of the computing device 2-10 receiving (e.g., via the network interface 2-120) the objective occurrence data 2-70* via one or more blog entries (e.g., microblog entries).

In some implementations, the reception operation 2-500 may include an operation 2-503 for receiving the objective occurrence data via one or more status reports as depicted in FIG. 2-5a. For instance, the objective occurrence data reception module 2-226 of the computing device 2-10 receiving (e.g., via the network interface 2-120) the objective occurrence data 2-70* via one or more status reports (e.g., social networking status reports).

In some implementations, the reception operation 2-500 may include an operation 2-504 for receiving the objective occurrence data via a Web 2.0 construct as depicted in FIG. 2-5a. For instance, the objective occurrence data reception module 2-226 of the computing device 2-10 receiving (e.g., via the network interface 2-120) the objective occurrence data 2-70* via a Web 2.0 construct (e.g., Web 2.0 application).

In some implementations, the reception operation 2-500 may include an operation 2-505 for receiving the objective occurrence data from one or more third party sources as depicted in FIG. 2-5a. For instance, the objective occurrence data reception module 2-226 of the computing device 2-10 receiving (e.g., via the network interface 2-120) the objective occurrence data 2-70* from one or more third party sources (e.g., a health care professional, a pharmacy, a hospital, a health care organization, a health monitoring service, a health care clinic, a school, a place of employment, a social group, a content provider, and so forth).

In some implementations, the reception operation 2-500 may include an operation 2-506 for receiving the objective occurrence data from one or more sensors configured to sense one or more objective occurrences associated with the user as depicted in FIG. 2-5a. For instance, the objective occurrence data reception module 2-226 of the computing device 2-10 receiving (e.g., via the network interface 2-120) the objective occurrence data 2-70* from one or more sensors 2-35 (e.g., a physiological sensing device, a physical activity sensing device such as a pedometer, a GPS, and so forth) configured to sense one or more objective occurrences associated with the user 2-20*.

In some implementations, the reception operation 2-500 may include an operation 2-507 for receiving the objective occurrence data from the user as depicted in FIG. 2-5a. For instance, the objective occurrence data reception module 2-226 of the computing device 2-10 receiving (e.g., via the network interface 2-120 or the user interface 2-122) the objective occurrence data 2-70* from the user 2-20*.

In some implementations, the objective occurrence data acquisition operation 2-304 may include an operation 2-508 for acquiring objective occurrence data including data indicating at least a second objective occurrence associated with the user as depicted in FIG. 2-5b. For instance, the objective occurrence data acquisition module 2-104 of the computing device 2-10 acquiring (e.g., via the network interface 2-120 or via the user interface 2-122) objective occurrence data 2-70* including data indicating at least a second objective occurrence associated with the user 2-20*.

In various implementations, operation 2-508 may further include one or more additional operations. For example, in some implementations, operation 2-508 may include an operation 2-509 for acquiring objective occurrence data including data indicating one objective occurrence associated with a first point in time and data indicating a second objective occurrence associated with a second point in time as depicted in FIG. 2-5b. For instance, the objective occurrence data acquisition module 2-104 of the computing device 2-10 acquiring (e.g., via the network interface 2-120 or via the user interface 2-122) objective occurrence data 2-70* including data indicating one objective occurrence (e.g., first meeting with the boss) associated with a first point in time (e.g., 8 AM Tuesday Oct. 10, 2009) and data indicating a second objective occurrence (e.g., second meeting with the boss) associated with a second point in time (e.g., 3 PM Friday Oct. 13, 2009).

In some implementations, operation 2-508 may include an operation 2-510 for acquiring objective occurrence data including data indicating one objective occurrence associated with a first time interval and data indicating a second objective occurrence associated with a second time interval as depicted in FIG. 2-5b. For instance, the objective occurrence data acquisition module 2-104 of the computing device 2-10 acquiring (e.g., via the network interface 2-120 or via the user interface 2-122) objective occurrence data 2-70* including data indicating one objective occurrence (e.g., jogging) associated with a first time interval (e.g., 7 PM to 8 PM Aug. 4, 2009) and data indicating a second objective occurrence (e.g., jogging) associated with a second time interval (e.g., 6 PM to 6:30 PM Aug. 12, 2009).

In some implementations, operation 2-508 may include an operation 2-511 for acquiring objective occurrence data including data indicating at least a second objective occurrence that is equivalent to the at least one objective occurrence as depicted in FIG. 2-5b. For instance, the objective occurrence data acquisition module 2-104 of the computing device 2-10 acquiring (e.g., via the network interface 2-120 or via the user interface 2-122) objective occurrence data 2-70* including data indicating at least a second objective occurrence (e.g., consuming three tablets of ibuprofen) that is equivalent to the at least one objective occurrence (e.g., consuming three tablets of ibuprofen).

Operation 2-511 in certain implementations may further include an operation 2-512 for acquiring objective occurrence data including data indicating at least a second objective occurrence that is at least proximately equivalent in meaning to the at least one objective occurrence as depicted in FIG. 2-5b. For instance, the objective occurrence data acquisition module 2-104 of the computing device 2-10 acquiring (e.g., via the network interface 2-120 or via the user interface 2-122) objective occurrence data 2-70* including data indicating at least a second objective occurrence (e.g., cloudy day) that is at least proximately equivalent in meaning to the at least one objective occurrence (e.g., overcast day).

In some implementations, operation 2-508 may include an operation 2-513 for acquiring objective occurrence data including data indicating at least a second objective occurrence that is proximately equivalent to the at least one objective occurrence as depicted in FIG. 2-5b. For instance, the objective occurrence data acquisition module 2-104 of the computing device 2-10 acquiring (e.g., via the network interface 2-120 or via the user interface 2-122) objective occurrence data 2-70* including data indicating at least a second objective occurrence (e.g., consuming three tablets of brand x ibuprofen) that is proximately equivalent to the one at least objective occurrence (e.g., consuming three tablets of brand y ibuprofen).

In some implementations, operation 2-508 may include an operation 2-514 for acquiring objective occurrence data including data indicating at least a second objective occurrence that is a contrasting objective occurrence from the at least one objective occurrence as depicted in FIG. 2-5c. For instance, the objective occurrence data acquisition module 2-104 of the computing device 2-10 acquiring (e.g., via the network interface 2-120 or via the user interface 2-122) objective occurrence data 2-70* including data indicating at least a second objective occurrence (e.g., consuming three tablets of brand x ibuprofen) that is a contrasting objective occurrence from the at least one objective occurrence (e.g., consuming one tablet of brand x ibuprofen or consuming no brand x ibuprofen tablets).

In some implementations, operation 2-508 may include an operation 2-515 for acquiring objective occurrence data including data indicating at least a second objective occurrence that references the at least one objective occurrence as depicted in FIG. 2-5c. For instance, the objective occurrence data acquisition module 2-104 of the computing device 2-10 acquiring (e.g., via the network interface 2-120 or via the user interface 2-122) objective occurrence data 2-70* including data indicating at least a second objective occurrence (e.g., today's temperature is the same as yesterday's) that references the at least one objective occurrence (e.g., 94 degrees).

Operation 2-515 may include one or more additional operations in various alternative implementations. For example, in some implementations, operation 2-515 may include an operation 2-516 for acquiring objective occurrence data including data indicating at least a second objective occurrence that is a comparison to the at least one objective occurrence as depicted in FIG. 2-5c. For instance, the objective occurrence data acquisition module 2-104 of the computing device 2-10 acquiring (e.g., via the network interface 2-120 or via the user interface 2-122) objective occurrence data 2-70* including data indicating at least a second objective occurrence (e.g., today's temperature is 10 degrees hotter than yesterday's) that is a comparison to the at least one objective occurrence (e.g., 84 degrees).

In some implementations, operation 2-515 may include an operation 2-517 for acquiring objective occurrence data including data indicating at least a second objective occurrence that is a modification of the at least one objective occurrence as depicted in FIG. 2-5c. For instance, the objective occurrence data acquisition module 2-104 of the computing device 2-10 acquiring (e.g., via the network interface 2-120 or via the user interface 2-122) objective occurrence data 2-70* including data indicating at least a second objective occurrence (e.g., the rain showers yesterday has changed over to a snow storm) that is a modification of the at least one objective occurrence (e.g., rain showers).

In some implementations, operation 2-515 may include an operation 2-518 for acquiring objective occurrence data including data indicating at least a second objective occurrence that is an extension of the at least one objective occurrence as depicted in FIG. 2-5c. For instance, the objective occurrence data acquisition module 2-104 of the computing device 2-10 acquiring (e.g., via the network interface 2-120 or via the user interface 2-122) objective occurrence data 2-70* including data indicating at least a second objective occurrence (e.g., my high blood pressure from yesterday is still present) that is an extension of the at least one objective occurrence (e.g., high blood pressure).

In various implementations, the objective occurrence data acquisition operation 2-304 of FIG. 2-3 may include an operation 2-519 for acquiring a time stamp associated with the at least one objective occurrence as depicted in FIG. 2-5d. For instance, the time stamp acquisition module 2-230 (see FIG. 2-2b) of the computing device 2-10 acquiring (e.g., via the network interface 2-120 or via the user interface 2-122 as provided by the user 2-20* or by automatically generating) a time stamp associated with the at least one objective occurrence.

Operation 2-519 in some implementations may further include an operation 2-520 for acquiring another time stamp associated with a second objective occurrence indicated by the objective occurrence data as depicted in FIG. 2-5d. For instance, the time stamp acquisition module 2-230 (see FIG. 2-2b) of the computing device 2-10 acquiring (e.g., via the network interface 2-120 or via the user interface 2-122 as provided by the user 2-20* or by automatically generating) another time stamp associated with a second objective occurrence indicated by the objective occurrence data 2-70*.

In some implementations, the objective occurrence data acquisition operation 2-304 may include an operation 2-521 for acquiring an indication of a time interval associated with the at least one objective occurrence as depicted in FIG. 2-5d. For instance, the time interval acquisition module 2-231 (see FIG. 2-2b) of the computing device 2-10 acquiring (e.g., via the network interface 2-120 or via the user interface 2-122 as provided by the user 2-20* or by automatically generating) an indication of a time interval associated with the at least one objective occurrence.

Operation 2-521 in some implementations may further include an operation 2-522 for acquiring another indication of another time interval associated with a second objective occurrence indicated by the objective occurrence data as depicted in FIG. 2-5d. For instance, the time interval acquisition module 2-231 of the computing device 2-10 acquiring (e.g., via the network interface 2-120 or via the user interface 2-122 as provided by the user 2-20* or by automatically generating) another indication of another time interval associated with a second objective occurrence indicated by the objective occurrence data 2-70*.

In some implementations, the objective occurrence data acquisition operation 2-304 of FIG. 2-3 may include an operation 2-523 for acquiring an indication of at least a temporal relationship between the at least one objective occurrence and a second objective occurrence indicated by the objective occurrence data as depicted in FIG. 2-5d. For instance, the temporal relationship acquisition module 2-232 (see FIG. 2-2b) of the computing device 2-10 acquiring (e.g., via the network interface 2-120 or via the user interface 2-122 as provided by the user 2-20* or by automatically generating) an indication of at least a temporal relationship between the at least one objective occurrence (e.g., drinking a soda right after eating a chocolate sundae) and a second objective occurrence (e.g., eating the chocolate sundae) indicated by the objective occurrence data 2-70*.

In some implementations, the objective occurrence data acquisition operation 2-304 may include an operation 2-524 for acquiring data indicating at least one objective occurrence associated with the user and one or more attributes associated with the at least one objective occurrence as depicted in FIG. 2-5d. For instance, the objective occurrence data acquisition module 2-104 of the computing device 2-10 acquiring (e.g., via the network interface 2-120 or via the user interface 2-122) data indicating at least one objective occurrence (e.g., exercising on an exercising machine) associated with the user 2-20* and one or more attributes (e.g., type of exercising machine or length of time on the exercise machine) associated with the at least one objective occurrence.

In various implementations, the objective occurrence data acquisition operation 2-304 may include an operation 2-525 for acquiring data indicating at least one objective occurrence of an ingestion by the user of a medicine as depicted in FIG. 2-5e. For instance, the objective occurrence data acquisition module 2-104 of the computing device 2-10 acquiring (e.g., via the network interface 2-120 or via the user interface 2-122) data indicating at least one objective occurrence of an ingestion by the user 2-20* of a medicine (e.g., a dosage of a beta blocker).

Operation 2-525 may further include, in some implementations, an operation 2-526 for acquiring data indicating another objective occurrence of another ingestion by the user of another medicine as depicted in FIG. 2-5e. For instance, the objective occurrence data acquisition module 2-104 of the computing device 2-10 acquiring (e.g., via the network interface 2-120 or via the user interface 2-122) data indicating another objective occurrence of another ingestion by the user 2-20* of another medicine (e.g., another ingestion of the beta blocker, an ingestion of another type of beta blocker, or ingestion of a completely different type of medicine).

Operation 2-526 may further include, in some implementations, an operation 2-527 for acquiring data indicating at least one objective occurrence of an ingestion by the user of a medicine and data indicating another objective occurrence of another ingestion by the user of another medicine, the ingestions of the medicine and the another medicine being ingestions of same or similar type of medicine as depicted in FIG. 2-5e. For instance, the objective occurrence data acquisition module 2-104 of the computing device 2-10 acquiring (e.g., via the network interface 2-120 or via the user interface 2-122) data indicating at least one objective occurrence of an ingestion by the user 2-20* of a medicine (e.g., an ingestion of a generic brand of beta blocker) and data indicating another objective occurrence of another ingestion by the user 2-20* of another medicine (e.g., another ingestion of the same generic brand of beta blocker or a different brand of the same type of beta blocker), the ingestions of the medicine and the another medicine being ingestions of same or similar type of medicine.

In some implementations, operation 2-527 may further include an operation 2-528 for acquiring data indicating at least one objective occurrence of an ingestion by the user of a medicine and data indicating another objective occurrence of another ingestion by the user of another medicine, the ingestions of the medicine and the another medicine being ingestions of same or similar quantities of the same or similar type of medicine as depicted in FIG. 2-5e. For instance, the objective occurrence data acquisition module 2-104 of the computing device 2-10 acquiring (e.g., via the network interface 2-120 or via the user interface 2-122) data indicating at least one objective occurrence of an ingestion by the user 2-20* of a medicine (e.g., 5 units of a generic brand of beta blocker) and data indicating another objective occurrence of another ingestion by the user 2-20* of another medicine (e.g., another 5 units of the same generic brand of beta blocker), the ingestions of the medicine and the another medicine being ingestions of same or similar quantities of the same or similar type of medicine.

In some alternative implementations, operation 2-526 may include an operation 2-529 for acquiring data indicating at least one objective occurrence of an ingestion by the user of a medicine and data indicating another objective occurrence of another ingestion by the user of another medicine, the ingestions of the medicine and the another medicine being ingestions of different types of medicine as depicted in FIG. 2-5e. For instance, the objective occurrence data acquisition module 2-104 of the computing device 2-10 acquiring (e.g., via the network interface 2-120 or via the user interface 2-122) data indicating at least one objective occurrence of an ingestion by the user 2-20* of a medicine (e.g., an ingestion of a particular type of beta blocker) and data indicating another objective occurrence of another ingestion by the user of another medicine (e.g., an ingestion of another type of beta blocker or an ingestion of a completely different type of medicine), the ingestions of the medicine and the another medicine being ingestions of different types of medicine.

In some implementations, the objective occurrence data acquisition operation 2-304 of FIG. 2-3 may include an operation 2-530 for acquiring data indicating at least one objective occurrence of an ingestion by the user of a food item as depicted in FIG. 2-5f. For instance, the objective occurrence data acquisition module 2-104 of the computing device 2-10 acquiring (e.g., via the network interface 2-120 or via the user interface 2-122) data indicating at least one objective occurrence of an ingestion by the user 2-20* of a food item (e.g., an apple).

Operation 2-530 may, in turn, include an operation 2-531 for acquiring data indicating another objective occurrence of another ingestion by the user of another food item as depicted in FIG. 2-5f. For instance, the objective occurrence data acquisition module 2-104 of the computing device 2-10 acquiring (e.g., via the network interface 2-120 or via the user interface 2-122) another objective occurrence of another ingestion by the user 2-20* of another food item (e.g., another apple, an orange, a hamburger, and so forth).

In some implementations, operation 2-531 may further include an operation 2-532 for acquiring data indicating at least one objective occurrence of an ingestion by the user of a food item and data indicating another objective occurrence of another ingestion by the user of another food item, the ingestions of the food item and the another food item being ingestions of same or similar type of food item as depicted in FIG. 2-5f. For instance, the objective occurrence data acquisition module 2-104 of the computing device 2-10 acquiring (e.g., via the network interface 2-120 or via the user interface 2-122) data indicating at least one objective occurrence of an ingestion by the user 2-20* of a food item (e.g., a Macintosh apple) and data indicating another objective occurrence of another ingestion by the user 2-20* of another food item (e.g., another Macintosh apple or a Fuji apple), the ingestions of the food item and the another food item being ingestions of same or similar type of food item.

In some implementations, operation 2-532 may further include an operation 2-533 for acquiring data indicating at least one objective occurrence of an ingestion by the user of a food item and data indicating another objective occurrence of another ingestion by the user of another food item, the ingestions of the food item and the another food item being ingestions of same or similar quantities of the same or similar type of food item as depicted in FIG. 2-5f. For instance, the objective occurrence data acquisition module 2-104 of the computing device 2-10 acquiring (e.g., via the network interface 2-120 or via the user interface 2-122) data indicating at least one objective occurrence of an ingestion by the user 2-20* of a food item (e.g., 10 ounces of a Macintosh apple) and data indicating another objective occurrence of another ingestion by the user 2-20* of another food item (e.g., 10 ounces of another Macintosh apple or a Fuji apple), the ingestions of the food item and the another food item being ingestions of same or similar quantities of the same or similar type of food item.

In some alternative implementations, operation 2-531 may include an operation 2-534 for acquiring data indicating at least one objective occurrence of an ingestion by the user of a food item and data indicating another objective occurrence of another ingestion by the user of another food item, the ingestions of the food item and the another food item being ingestions of different types of food item as depicted in FIG. 2-5f. For instance, the objective occurrence data acquisition module 2-104 of the computing device 2-10 acquiring (e.g., via the network interface 2-120 or via the user interface 2-122) data indicating at least one objective occurrence of an ingestion by the user 2-20* of a food item (e.g., an apple) and data indicating another objective occurrence of another ingestion by the user 2-20* of another food item (e.g., a banana), the ingestions of the food item and the another food item being ingestions of different types of food item.

In some implementations, the objective occurrence data acquisition operation 2-304 of FIG. 2-3 may include an operation 2-535 for acquiring data indicating at least one objective occurrence of an ingestion by the user of a nutraceutical as depicted in FIG. 2-5g. For instance, the objective occurrence data acquisition module 2-104 of the computing device 2-10 acquiring (e.g., via the network interface 2-120 or via the user interface 2-122) data indicating at least one objective occurrence of an ingestion by the user 2-20* of a nutraceutical (e.g. broccoli).

Operation 2-535 in certain implementations may further include an operation 2-536 for acquiring data indicating another objective occurrence of another ingestion by the user of another nutraceutical as depicted in FIG. 2-5g. For instance, the objective occurrence data acquisition module 2-104 of the computing device 2-10 acquiring (e.g., via the network interface 2-120 or via the user interface 2-122) data indicating another objective occurrence of another ingestion by the user 2-20* of another nutraceutical (e.g., another broccoli, red grapes, soy beans, or some other type of nutraceutical).

In some implementations, operation 2-536 may include an operation 2-537 for acquiring data indicating at least one objective occurrence of an ingestion by the user of a nutraceutical and data indicating another objective occurrence of another ingestion by the user of another nutraceutical, the ingestions of the nutraceutical and the another nutraceutical being ingestions of same or similar type of nutraceutical as depicted in FIG. 2-5g. For instance, the objective occurrence data acquisition module 2-104 of the computing device 2-10 acquiring (e.g., via the network interface 2-120 or via the user interface 2-122) data indicating at least one objective occurrence of an ingestion by the user 2-20* of a nutraceutical (e.g., red grapes) and data indicating another objective occurrence of another ingestion by the user of another nutraceutical (e.g., red grapes), the ingestions of the nutraceutical and the another nutraceutical being ingestions of same or similar type of nutraceutical.

Operation 2-537 may, in some instances, further include an operation 2-538 for acquiring data indicating at least one objective occurrence of an ingestion by the user of a nutraceutical and data indicating another objective occurrence of another ingestion by the user of another nutraceutical, the ingestions of the nutraceutical and the another nutraceutical being ingestions of same or similar quantities of the same or similar type of nutraceutical as depicted in FIG. 2-5g. For instance, the objective occurrence data acquisition module 2-104 of the computing device 2-10 acquiring (e.g., via the network interface 2-120 or via the user interface 2-122) data indicating at least one objective occurrence of an ingestion by the user 2-20* of a nutraceutical (e.g., 12 ounces of red grapes) and data indicating another objective occurrence of another ingestion by the user 2-20* of another nutraceutical (e.g., 12 ounces of red grapes), the ingestions of the nutraceutical and the another nutraceutical being ingestions of same or similar quantities of the same or similar type of nutraceutical.

In some alternative implementations, operation 2-536 may include an operation 2-539 for acquiring data indicating at least one objective occurrence of an ingestion by the user of a nutraceutical and data indicating another objective occurrence of another ingestion by the user of another nutraceutical, the ingestions of the nutraceutical and the another nutraceutical being ingestions of different types of nutraceutical as depicted in FIG. 2-5g. For instance, the objective occurrence data acquisition module 2-104 of the computing device 2-10 acquiring (e.g., via the network interface 2-120 or via the user interface 2-122) data indicating at least one objective occurrence of an ingestion by the user 2-20* of a nutraceutical (e.g., red grapes) and data indicating another objective occurrence of another ingestion by the user 2-20* of another nutraceutical (e.g., soy beans), the ingestions of the nutraceutical and the another nutraceutical being ingestions of different types of nutraceutical.

In some implementations, the objective occurrence data acquisition operation 2-304 of FIG. 2-3 may include an operation 2-540 for acquiring data indicating at least one objective occurrence of an exercise routine executed by the user as depicted in FIG. 2-5h. For instance, the objective occurrence data acquisition module 2-104 of the computing device 2-10 acquiring (e.g., via the network interface 2-120 or via the user interface 2-122) data indicating at least one objective occurrence of an exercise routine (e.g., jogging) executed by the user 2-20*.

In various implementations, operation 2-540 may further include an operation 2-541 for acquiring data indicating another objective occurrence of another exercise routine executed by the user as depicted in FIG. 2-5h. For instance, the objective occurrence data acquisition module 2-104 of the computing device 2-10 acquiring (e.g., via the network interface 2-120 or via the user interface 2-122) data indicating another objective occurrence of another exercise routine (e.g., jogging again, weightlifting, aerobics, treadmill, or some other exercise routine) executed by the user 2-20*.

In some implementations, operation 2-541 may further include an operation 2-542 for acquiring data indicating at least one objective occurrence of an exercise routine executed by the user and data indicating another objective occurrence of another exercise routine executed by the user, the exercise routines executed by the user being the same or similar type of exercise routine as depicted in FIG. 2-5h. For instance, the objective occurrence data acquisition module 2-104 of the computing device 2-10 acquiring (e.g., via the network interface 2-120 or via the user interface 2-122) data indicating at least one objective occurrence of an exercise routine (e.g., working out on an elliptical machine) executed by the user 2-20* and data indicating another objective occurrence of another exercise routine (e.g., working out on a treadmill) executed by the user 2-20*, the exercise routines executed by the user 2-20* being the same or similar type of exercise routine.

In some implementations, operation 2-542 may further include an operation 2-543 for acquiring data indicating at least one objective occurrence of an exercise routine executed by the user and data indicating another objective occurrence of another exercise routine executed by the user, the exercise routines executed by the user being the same or similar quantity of the same or similar type of exercise routine as depicted in FIG. 2-5h. For instance, the objective occurrence data acquisition module 2-104 of the computing device 2-10 acquiring (e.g., via the network interface 2-120 or via the user interface 2-122) data indicating at least one objective occurrence of an exercise routine (e.g., working out on an elliptical machine for 30 minutes) executed by the user 2-20*and data indicating another objective occurrence of another exercise routine (e.g., working out on a treadmill for 27 minutes) executed by the user 2-20*, the exercise routines executed by the user 2-20* being the same or similar quantity of the same or similar type of exercise routine.

In some implementations, operation 2-541 may include an operation 2-544 for acquiring data indicating at least one objective occurrence of an exercise routine executed by the user and data indicating another objective occurrence of another exercise routine executed by the user, the exercise routines executed by the user being different types of exercise routine as depicted in FIG. 2-5h. For instance, the objective occurrence data acquisition module 2-104 of the computing device 2-10 acquiring (e.g., via the network interface 2-120 or via the user interface 2-122) data indicating at least one objective occurrence of an exercise routine (e.g., working out on a treadmill) executed by the user 2-20* and data indicating another objective occurrence of another exercise routine (e.g., lifting weights) executed by the user 2-20*, the exercise routines executed by the user 2-20* being different types of exercise routine.

In some implementations, the objective occurrence data acquisition operation 2-304 of FIG. 2-3 may include an operation 2-545 for acquiring data indicating at least one objective occurrence of a social activity executed by the user as depicted in FIG. 2-5i. For instance, the objective occurrence data acquisition module 2-104 of the computing device 2-10 acquiring (e.g., via the network interface 2-120 or via the user interface 2-122) data indicating at least one objective occurrence of a social activity (e.g., hiking with friends) executed by the user 2-20*.

In some implementations, operation 2-545 may further include an operation 2-546 acquiring data indicating another objective occurrence of another social activity executed by the user as depicted in FIG. 2-5i. For instance, the objective occurrence data acquisition module 2-104 of the computing device 2-10 acquiring (e.g., via the network interface 2-120 or via the user interface 2-122) data indicating another objective occurrence of another social activity (e.g., hiking again with friends, skiing with friends, dining with friends, and so forth) executed by the user 2-20*.

In some implementations, operation 2-546 may include an operation 2-547 for acquiring data indicating at least one objective occurrence of a social activity executed by the user and data indicating another objective occurrence of another social activity executed by the user, the social activities executed by the user being same or similar type of social activities as depicted in FIG. 2-5i. For instance, the objective occurrence data acquisition module 2-104 of the computing device 2-10 acquiring (e.g., via the network interface 2-120 or via the user interface 2-122) data indicating at least one objective occurrence of a social activity (e.g., dinner with friends) executed by the user 2-20* and data indicating another objective occurrence of another social activity (e.g., another dinner with friends) executed by the user 2-20*, the social activities executed by the user 2-20* being same or similar type of social activities.

In some implementations, operation 2-546 may include an operation 2-548 for acquiring data indicating at least one objective occurrence of a social activity executed by the user and data indicating another objective occurrence of another social activity executed by the user, the social activities executed by the user being different types of social activity as depicted in FIG. 2-5i. For instance, the objective occurrence data acquisition module 2-104 of the computing device 2-10 acquiring (e.g., via the network interface 2-120 or via the user interface 2-122) data indicating at least one objective occurrence of a social activity (e.g., dinner with friends) executed by the user 2-20* and data indicating another objective occurrence of another social activity (e.g., dinner with in-laws) executed by the user 2-20*, the social activities executed by the user 2-20* being different types of social activity.

In some implementations, the objective occurrence data acquisition operation 2-304 of FIG. 2-3 may include an operation 2-549 for acquiring data indicating at least one objective occurrence of an activity performed by a third party as depicted in FIG. 2-5i. For instance, the objective occurrence data acquisition module 2-104 of the computing device 2-10 acquiring (e.g., via the network interface 2-120 or via the user interface 2-122) data indicating at least one objective occurrence of an activity (e.g., boss on a vacation) performed by a third party 2-50.

Operation 2-549, in some instances, may further include an operation 2-550 for acquiring data indicating another objective occurrence of another activity performed by the third party as depicted in FIG. 2-5i. For instance, the objective occurrence data acquisition module 2-104 of the computing device 2-10 acquiring (e.g., via the network interface 2-120 or via the user interface 2-122) data indicating another objective occurrence of another activity (e.g., boss on a vacation again, boss away from office on business trip, or boss in the office) performed by the third party 2-50.

In some implementations, operation 2-550 may include an operation 2-551 for acquiring data indicating at least one objective occurrence of an activity performed by a third party and data indicating another objective occurrence of another activity performed by the third party, the activities performed by the third party being same or similar type of activities as depicted in FIG. 2-5i. For instance, the objective occurrence data acquisition module 2-104 of the computing device 2-10 acquiring (e.g., via the network interface 2-120 or via the user interface 2-122) data indicating at least one objective occurrence of an activity (e.g., boss away from office on business trip) performed by a third party 2-50 and data indicating another objective occurrence of another activity (e.g., boss again away from office on another business trip) performed by the third party 2-50, the activities performed by the third party 2-50 being same or similar type of activities.

In some implementations, operation 2-550 may include an operation 2-552 for acquiring data indicating at least one objective occurrence of an activity performed by a third party and data indicating another objective occurrence of another activity performed by the third party, the activities performed by the third party being different types of activity as depicted in FIG. 2-5i. For instance, the objective occurrence data acquisition module 2-104 of the computing device 2-10 acquiring (e.g., via the network interface 2-120 or via the user interface 2-122) data indicating at least one objective occurrence of an activity (e.g., boss away on vacation) performed by a third party 2-50 and data indicating another objective occurrence of another activity (e.g., boss returning to office from vacation) performed by the third party 2-50, the activities performed by the third party 2-50 being different types of activity.

In some implementations, the objective occurrence data acquisition operation 2-304 of FIG. 2-3 may include an operation 2-553 for acquiring data indicating at least one objective occurrence of a physical characteristic of the user as depicted in FIG. 2-5j. For instance, the objective occurrence data acquisition module 2-104 of the computing device 2-10 acquiring (e.g., via the network interface 2-120 or via the user interface 2-122) data indicating at least one objective occurrence of a physical characteristic (e.g., a blood sugar level) of the user 2-20*. Note that a physical characteristic such as a blood sugar level could be determined using a device such as a blood sugar meter and then reported by the user 2-20* or by a third party 2-50. Alternatively, such results may be reported or provided directly by the meter.

Operation 2-553, in some instances, may further include an operation 2-554 for acquiring data indicating another objective occurrence of another physical characteristic of the user as depicted in FIG. 2-5j. For instance, the objective occurrence data acquisition module 2-104 of the computing device 2-10 acquiring (e.g., via the network interface 2-120 or via the user interface 2-122) data indicating another objective occurrence of another physical characteristic (e.g., another blood sugar level or a blood pressure measurement) of the user 2-20*.

In some implementations, operation 2-554 may include an operation 2-555 for acquiring data indicating at least one objective occurrence of a physical characteristic of the user and data indicating another objective occurrence of another physical characteristic of the user, the physical characteristics of the user being same or similar type of physical characteristic as depicted in FIG. 2-5j. For instance, the objective occurrence data acquisition module 2-104 of the computing device 2-10 acquiring (e.g., via the network interface 2-120 or via the user interface 2-122) data indicating at least one objective occurrence of a physical characteristic (e.g., blood sugar level of 2-220) of the user 2-20* and data indicating another objective occurrence of another physical characteristic (e.g., blood sugar level of 2-218) of the user 2-20*, the physical characteristics of the user 2-20* being same or similar type of physical characteristic.

In some implementations, operation 2-554 may include an operation 2-556 for acquiring data indicating at least one objective occurrence of a physical characteristic of the user and data indicating another objective occurrence of another physical characteristic of the user, the physical characteristics of the user being different types of physical characteristic as depicted in FIG. 2-5j. For instance, the objective occurrence data acquisition module 2-104 of the computing device 2-10 acquiring (e.g., via the network interface 2-120 or via the user interface 2-122) data indicating at least one objective occurrence of a physical characteristic (e.g., high blood pressure) of the user 2-20* and data indicating another objective occurrence of another physical characteristic (e.g., low blood pressure) of the user 2-20*, the physical characteristics of the user 2-20* being different types of physical characteristic.

In some implementations, the objective occurrence data acquisition operation 2-304 may include an operation 2-557 for acquiring data indicating at least one objective occurrence of a resting, a learning, or a recreational activity by the user as depicted in FIG. 2-5j. For instance, the objective occurrence data acquisition module 2-104 of the computing device 2-10 acquiring (e.g., via the network interface 2-120 or via the user interface 2-122) data indicating at least one objective occurrence of a resting (e.g., sleeping), a learning (e.g., reading), or a recreational activity (e.g., a round of golf) by the user 2-20*.

Operation 2-557, in some instances, may further include an operation 2-558 for acquiring data indicating another objective occurrence of another resting, another learning, or another recreational activity by the user as depicted in FIG. 2-5j. For instance, the objective occurrence data acquisition module 2-104 of the computing device 2-10 acquiring (e.g., via the network interface 2-120 or via the user interface 2-122) data indicating another objective occurrence of another resting (e.g., watching television), another learning (e.g., attending a class or seminar), or another recreational activity (e.g., another round of golf) by the user 2-20*.

In some implementations, the objective occurrence data acquisition operation 2-304 may include an operation 2-559 for acquiring data indicating at least one objective occurrence of an external event as depicted in FIG. 2-5j. For instance, the objective occurrence data acquisition module 2-104 of the computing device 2-10 acquiring (e.g., via the network interface 2-120 or via the user interface 2-122) data indicating at least one objective occurrence of an external event (e.g., rain storm).

Operation 2-559, in some instances, may further include an operation 2-560 for acquiring data indicating another objective occurrence of another external event as depicted in FIG. 2-5j. For instance, the objective occurrence data acquisition module 2-104 of the computing device 2-10 acquiring (e.g., via the network interface 2-120 or via the user interface 2-122) data indicating another objective occurrence of another external event (e.g., another rain storm or sunny clear weather).

In some implementations, operation 2-560 may include an operation 2-561 for acquiring data indicating at least one objective occurrence of an external event and data indicating another objective occurrence of another external event, the external events being same or similar type of external event as depicted in FIG. 2-5j. For instance, the objective occurrence data acquisition module 2-104 of the computing device 2-10 acquiring (e.g., via the network interface 2-120 or via the user interface 2-122) data indicating at least one objective occurrence of an external event (e.g., rain storm) and data indicating another objective occurrence of another external event (e.g., another rain storm), the external events being same or similar type of external event.

In some implementations, operation 2-560 may include an operation 2-562 for acquiring data indicating at least one objective occurrence of an external event and data indicating another objective occurrence of another external event, the external events being different types of external event as depicted in FIG. 2-5j. For instance, the objective occurrence data acquisition module 2-104 of the computing device 2-10 acquiring (e.g., via the network interface 2-120 or via the user interface 2-122) data indicating at least one objective occurrence of an external event (e.g., rain storm) and data indicating another objective occurrence of another external event (e.g., sunny clear weather), the external events being different types of external event.

In some implementations, the objective occurrence data acquisition operation 2-304 of FIG. 2-3 may include an operation 2-563 for acquiring data indicating at least one objective occurrence related to a location of the user as depicted in FIG. 2-5k. For instance, the objective occurrence data acquisition module 2-104 of the computing device 2-10 acquiring (e.g., via the network interface 2-120 or via the user interface 2-122) data indicating at least one objective occurrence related to a location (e.g., work office at a first point or interval in time) of the user 2-20*. In some instances, such data may be provided by the user 2-20* via the user interface 2-122 (e.g., in the case where the computing device 2-10 is a local device) or via the mobile device 2-30 (e.g., in the case where the computing device 2-10 is a network server). Alternatively, such data may be provided directly by a sensor device 2-35 such as a GPS device, or by a third party 2-50.

Operation 2-563, in some instances, may further include an operation 2-564 for acquiring data indicating another objective occurrence related to another location of the user as depicted in FIG. 2-5k. For instance, the objective occurrence data acquisition module 2-104 of the computing device 2-10 acquiring (e.g., via the network interface 2-120 or via the user interface 2-122) data indicating another objective occurrence related to another location (e.g., work office or home at a second point or interval in time) of the user 2-20*.

In some implementations, operation 2-564 may include an operation 2-565 for acquiring data indicating at least one objective occurrence related to a location of the user and data indicating another objective occurrence related to another location of the user, the locations being same or similar location as depicted in FIG. 2-5k. For instance, the objective occurrence data acquisition module 2-104 of the computing device 2-10 acquiring (e.g., via the network interface 2-120 or via the user interface 2-122) data indicating at least one objective occurrence related to a location (e.g., work office at a first point or interval in time) of the user 2-20* and data indicating another objective occurrence related to another location (e.g., work office at a second point or interval in time) of the user 2-20*, the locations being same or similar location.

In some implementations, operation 2-564 may include an operation 2-566 for acquiring data indicating at least one objective occurrence related to a location of the user and data indicating another objective occurrence related to another location of the user, the locations being different locations as depicted in FIG. 2-5k. For instance, the objective occurrence data acquisition module 2-104 of the computing device 2-10 acquiring (e.g., via the network interface 2-120 or via the user interface 2-122) data indicating at least one objective occurrence related to a location (e.g., work office at a first point or interval in time) of the user 2-20* and data indicating another objective occurrence related to another location (e.g., home at a second point or interval in time) of the user 2-20*, the locations being different locations.

In some implementations, the objective occurrence data acquisition operation 2-304 may include an operation 2-569 for soliciting the objective occurrence data including data indicating at least one objective occurrence associated with the user as depicted in FIG. 2-5k. For instance, the objective occurrence data solicitation module 2-234 (see FIG. 2-2b) of the computing device 2-10 soliciting (e.g., via the user interface 2-122 or transmitting a request via the network interface 2-120) the objective occurrence data 2-70* including data indicating at least one objective occurrence associated with the user 2-20*.

In various implementations, operation 2-569 may include one or more additional operations. For instance, in some implementations, operation 2-569 may include an operation 2-570 for soliciting from the user the objective occurrence data as depicted in FIG. 2-5k. For instance, the objective occurrence data solicitation module 2-234 of the computing device 2-10 soliciting (e.g., via the user interface 2-122 or by transmitting a request via the network interface 2-120) from the user 2-20* the objective occurrence data 2-70*.

In some implementations, operation 2-569 may include an operation 2-571 for soliciting from a third party source the objective occurrence data as depicted in FIG. 2-5k. For instance, the objective occurrence data solicitation module 2-234 of the computing device 2-10 soliciting (e.g., by transmitting a request via the network interface 2-120) from a third party source (e.g., content provider, medical or dental entity, other users 2-20* such as a spouse, a friend, or a boss, or other third party sources) the objective occurrence data 2-70a.

In some implementations, operation 2-569 may include an operation 2-572 for soliciting the objective occurrence data in response to a reporting of a subjective user state as depicted in FIG. 2-5k. For instance, the objective occurrence data solicitation module 2-234 of the computing device 2-10 soliciting (e.g., via the user interface 2-122 or by transmitting a request via the network interface 2-120) the objective occurrence data 2-70* in response to a reporting of a subjective user state. For example, upon receiving a reporting of a hangover, asking the user 2-20* whether the user 2-20* had drunk alcohol?

Referring back to FIG. 2-3, the correlation operation 2-306 may include one or more additional operations in various alternative implementations. For example, in various implementations, the correlation operation 2-306 may include an operation 2-604 for correlating the subjective user state data with the objective occurrence data based, at least in part, on a determination of whether the at least one subjective user state occurred within a predefined time increment from incidence of the at least one objective occurrence as depicted in FIG. 2-6a. For instance, the correlation module 2-106 of the computing device 2-10 correlating the subjective user state data 2-60 with the objective occurrence data 2-70* based, at least in part, on a determination by the “within predefined time increment determination” module 2-238 (see FIG. 2-2c) of whether the at least one subjective user state occurred within a predefined time increment from incidence of the at least one objective occurrence.

In some implementations, the correlation operation 2-306 may include an operation 2-608 for correlating the subjective user state data with the objective occurrence data based, at least in part, on a determination of whether the at least one subjective user state occurred before, after, or at least partially concurrently with incidence of the at least one objective occurrence as depicted in FIG. 2-6a. For instance, the correlation module 2-106 of the computing device 2-10 correlating the subjective user state data 2-60 with the objective occurrence data 2-70* based, at least in part, on a determination by the temporal relationship determination module 2-239 of whether the at least one subjective user state occurred before, after, or at least partially concurrently with incidence of the at least one objective occurrence.

In some implementations, the correlation operation 2-306 may include an operation 2-614 for correlating the subjective user state data with the objective occurrence data based, at least in part, on referencing historical data as depicted in FIG. 2-6a. For instance, the correlation module 2-106 of the computing device 2-10 correlating the subjective user state data 2-60 with the objective occurrence data 2-70* based, at least in part, on referencing by the historical data referencing data 2-241 of historical data (e.g., population trends such as the superior efficacy of ibuprofen as opposed to acetaminophen in reducing toothaches in the general population, user medical data such as genetic, metabolome, or proteome information, historical sequential patterns particular to the user 2-20* or to the overall population such as people having a hangover after drinking excessively, and so forth).

In various implementations, operation 2-614 may include one or more operations. For example, in some implementations, operation 2-614 may include an operation 2-616 for correlating the subjective user state data with the objective occurrence data based, at least in part, on historical data indicative of a link between a subjective user state type and an objective occurrence type as depicted in FIG. 2-6a. For instance, the correlation module 2-106 of the computing device 2-10 correlating the subjective user state data 2-60 with the objective occurrence data 2-70* based, at least in part, on the historical data referencing module 2-241 referencing historical data indicative of a link between a subjective user state type and an objective occurrence type (e.g., historical data suggests or indicate a link between a person's mental well-being and exercise).

In some implementations, operation 2-616 may further include an operation 2-618 for correlating the subjective user state data with the objective occurrence data based, at least in part, on a historical sequential pattern as depicted in FIG. 2-6a. For instance, the correlation module 2-106 of the computing device 2-10 correlating the subjective user state data 2-60 with the objective occurrence data 2-70* based, at least in part, on the historical data referencing module 2-241 referencing a historical sequential pattern (e.g., research indicates that people tend to feel better after exercising).

In some implementations, operation 2-614 may include an operation 2-620 for correlating the subjective user state data with the objective occurrence data based, at least in part, on historical medical data of the user as depicted in FIG. 2-6a. For instance, the correlation module 2-106 of the computing device 2-10 correlating the subjective user state data 2-60 with the objective occurrence data 2-70* based, at least in part, on the historical data referencing module 2-241 referencing historical medical data (e.g., genetic, metabolome, or proteome information or medical records of the user 2-20* or of others related to, for example, diabetes or heart disease).

In various implementations, the correlation operation 2-306 of FIG. 2-3 may include an operation 2-622 for determining a second sequential pattern associated with at least a second subjective user state indicated by the subjective user state data and at least a second objective occurrence indicated by the objective occurrence data as depicted in FIG. 2-6b. For instance, the sequential pattern determination module 2-236 of the computing device 2-10 determining a second sequential pattern associated with at least a second subjective user state indicated by the subjective user state data 2-60 and at least a second objective occurrence indicated by the objective occurrence data 2-70*.

Operation 2-622, in some instances, may further include an operation 2-623 for comparing the one sequential pattern to the second sequential pattern to determine whether the first sequential pattern at least substantially matches the second sequential pattern as depicted in FIG. 2-6b. For instance, the sequential pattern comparison module 2-242 (see FIG. 2-2c) of the computing device 2-10 comparing the one sequential pattern to the second sequential pattern to determine whether the first sequential pattern at least substantially matches the second sequential pattern.

In various alternative implementations, operation 2-623 may further include one or more additional operations. For example, in some implementations, operation 2-623 may include an operation 2-624 for determining whether the at least one subjective user state is equivalent to the at least a second subjective user state as depicted in FIG. 2-6b. For instance, the subjective user state equivalence determination module 2-243 (see FIG. 2-2c) of the computing device 2-10 determining whether the at least one subjective user state (e.g., backache) is equivalent to the at least a second subjective user state (e.g., backache).

In some implementations, operation 2-623 may include an operation 2-626 for determining whether the at least one subjective user state is at least proximately equivalent in meaning to the at least a second subjective user state as depicted in FIG. 2-6b. For instance, the subjective user state equivalence determination module 2-243 of the computing device 2-10 determining whether the at least one subjective user state (e.g., angry) is at least proximately equivalent in meaning to the at least a second subjective user state (e.g., enraged).

In some implementations, operation 2-623 may include an operation 2-628 for determining whether the at least one subjective user state is proximately equivalent to the at least a second subjective user state as depicted in FIG. 2-6b. For instance, the subjective user state equivalence determination module 2-243 of the computing device 2-10 determining whether the at least one subjective user state (e.g., slightly drowsy) is proximately equivalent to the at least a second subjective user state (e.g., somewhat drowsy).

In some implementations, operation 2-623 may include an operation 2-630 for determining whether the at least one subjective user state is a contrasting subjective user state from the at least a second subjective user state as depicted in FIG. 2-6b. For instance, the subjective user state contrast determination module 2-245 (see FIG. 2-2c) of the computing device 2-10 determining whether the at least one subjective user state (e.g., extreme pain) is a contrasting subjective user state from the at least a second subjective user state (e.g., moderate or no pain).

In some implementations, operation 2-623 may include an operation 2-632 for determining whether the at least one objective occurrence is equivalent to the at least a second objective occurrence as depicted in FIG. 2-6b. For instance, the objective occurrence equivalence determination module 2-244 (see FIG. 2-2c) of the computing device 2-10 determining whether the at least one objective occurrence (e.g., drinking green tea) is equivalent to the at least a second objective occurrence (e.g., drinking green tea).

In some implementations, operation 2-623 may include an operation 2-634 for determining whether the at least one objective occurrence is at least proximately equivalent in meaning to the at least a second objective occurrence as depicted in FIG. 2-6b. For instance, the objective occurrence equivalence determination module 2-244 of the computing device 2-10 determining whether the at least one objective occurrence (e.g., overcast day) is at least proximately equivalent in meaning to the at least a second objective occurrence (e.g., cloudy day).

In some implementations, operation 2-623 may include an operation 2-636 for determining whether the at least one objective occurrence is proximately equivalent to the at least a second objective occurrence as depicted in FIG. 2-6c. For instance, the objective occurrence equivalence determination module 2-244 of the computing device 2-10 determining whether the at least one objective occurrence (e.g., jogging for 30 minutes) is proximately equivalent to the at least a second objective occurrence (e.g., jogging for 25 minutes).

In some implementations, operation 2-623 may include an operation 2-638 for determining whether the at least one objective occurrence is a contrasting objective occurrence from the at least a second objective occurrence as depicted in FIG. 2-6c. For instance, the objective occurrence contrast determination module 2-246 (see FIG. 2-2c) of the computing device 2-10 determining whether the at least one objective occurrence (e.g., jogging for one hour) is a contrasting objective occurrence from the at least a second objective occurrence (e.g., jogging for thirty minutes or not jogging at all).

In some implementations, operation 2-623 may include an operation 2-640 for determining whether the at least one subjective user state occurred within a predefined time increment from incidence of the at least one objective occurrence as depicted in FIG. 2-6c. For instance, the “within predefined time increment” determination module 2-238 of the computing device 2-10 determining whether the at least one subjective user state (e.g., upset stomach) occurred within a predefined time increment (e.g., three hours) from incidence of the at least one objective occurrence (e.g., eating a chocolate sundae).

Operation 2-640 may, in some instances, include an additional operation 2-642 for determining whether the at least a second subjective user state occurred within the predefined time increment from incidence of the at least a second objective occurrence as depicted in FIG. 2-6c. For instance, the “within predefined time increment” determination module 2-238 of the computing device 2-10 determining whether the at least a second subjective user state (e.g., another upset stomach) occurred within the predefined time increment (e.g., three hours) from incidence of the at least a second objective occurrence (e.g., eating another chocolate sundae).

In various implementations, operation 2-622 may include an operation 2-644 for determining a first sequential pattern by determining at least whether the at least one subjective user state occurred before, after, or at least partially concurrently with incidence of the at least one objective occurrence as depicted in FIG. 2-6c. For instance, the temporal relationship determination module 2-239 of the computing device 2-10 determining a first sequential pattern by determining at least whether the at least one subjective user state occurred before, after, or at least partially concurrently with incidence of the at least one objective occurrence.

In some implementations, operation 2-644 may include an additional operation 2-646 for determining the second sequential pattern by determining at least whether the at least a second subjective user state occurred before, after, or at least partially concurrently with incidence of the at least a second objective occurrence as depicted in FIG. 2-6c. For instance, the temporal relationship determination module 2-239 of the computing device 2-10 determining the second sequential pattern by determining at least whether the at least a second subjective user state occurred before, after, or at least partially concurrently with incidence of the at least a second objective occurrence.

In various implementations, operation 2-622 may include an operation 2-650 for determining the one sequential pattern by determining at least an extent of time difference between incidence of the at least one subjective user state and incidence of the at least one objective occurrence as depicted in FIG. 2-6d. For instance, the subjective user state and objective occurrence time difference determination module 2-240 of the computing device 2-10 determining the one sequential pattern by determining at least an extent of time difference (e.g., one hour) between incidence of the at least one subjective user state (e.g., upset stomach) and incidence of the at least one objective occurrence (e.g., consumption of chocolate sundae).

Operation 2-650 may, in some instances, include an additional operation 2-652 for determining the second sequential pattern by determining at least an extent of time difference between incidence of the at least a second subjective user state and incidence of the at least a second objective occurrence as depicted in FIG. 2-6d. For instance, the subjective user state and objective occurrence time difference determination module 2-240 of the computing device 2-10 determining the second sequential pattern by determining at least an extent of time difference (e.g., two hours) between incidence of the at least a second subjective user state (e.g., another upset stomach) and incidence of the at least a second objective occurrence (e.g., consumption of another chocolate sundae).

In some implementations, the correlation operation 2-306 of FIG. 2-3 may include an operation 2-656 for determining strength of correlation between the subjective user state data and the objective occurrence data as depicted in FIG. 2-6d. For instance, the strength of correlation determination module 2-250 (see FIG. 2-2c) of the computing device 2-10 determining strength of correlation between the subjective user state data 2-60 and the objective occurrence data 2-70* based, at least in part, on results provided by the sequential pattern comparison module 2-242.

In some implementations, the correlation operation 2-306 may include an operation 2-658 for correlating the subjective user state data with the objective occurrence data at a server as depicted in FIG. 2-6d. For instance, the correlation module 2-106 of the computing device 2-10 correlating the subjective user state data 2-60 with the objective occurrence data 2-70* when the computing device 2-10 is a network server.

In some implementations, the correlation operation 2-306 may include an operation 2-660 for correlating the subjective user state data with the objective occurrence data at a handheld device as depicted in FIG. 2-6d. For instance, the correlation module 2-106 of the computing device 2-10 correlating the subjective user state data 2-60 with the objective occurrence data 2-70* when the computing device 2-10 is a handheld device.

In some implementations, the correlation operation 2-306 may include an operation 2-662 for correlating the subjective user state data with the objective occurrence data at a peer-to-peer network component device as depicted in FIG. 2-6d. For instance, the correlation module 2-106 of the computing device 2-10 correlating the subjective user state data 2-60 with the objective occurrence data 2-70* when the computing device 2-10 is a peer-to-peer network component device.

Referring back to FIG. 2-3, the presentation operation 2-308 may include one or more additional operations in various alternative embodiments. For example, in some implementations, the presentation operation 2-308 may include a display operation 2-702 for displaying the one or more results via a user interface as depicted in FIG. 2-7a. For instance, the display module 2-254 (see FIG. 2-2d) of the computing device 2-10 displaying the one or more results of the correlation via a user interface 2-122.

In some implementations, the presentation operation 2-308 may include a transmission operation 2-704 for transmitting the one or more results via a network interface as depicted in FIG. 2-7a. For instance, the transmission module 2-252 (see FIG. 2-2d) of the computing device 2-10 transmitting the one or more results of the correlation via a network interface 2-120.

The transmission operation 2-704 may further include one or more additional operations. For example, in some implementations, the transmission operation 2-704 may include an operation 2-706 for transmitting the one or more results to the user as depicted in FIG. 2-7a. For instance, the transmission module 2-252 of the computing device 2-10 transmitting the one or more results of the correlation to the user 2-20a.

In some implementations, the transmission operation 2-704 may include an operation 2-708 for transmitting the one or more results to one or more third parties as depicted in FIG. 2-7a. For instance, the transmission module 2-252 of the computing device 2-10 transmitting the one or more results of the correlation to one or more third parties 2-50.

In some implementations, the presentation operation 2-308 of FIG. 2-3 may include an operation 2-710 for presenting an indication of a sequential relationship between the at least one subjective user state and the at least one objective occurrence as depicted in FIG. 2-7a. For instance, the sequential relationship presentation module 2-256 (see FIG. 2-2d) of the computing device 2-10 presenting an indication of a sequential relationship between the at least one subjective user state (e.g., hangover) and the at least one objective occurrence (e.g., drinking five shots of whiskey). An example indication might state that the “last time the user drank five shots of whiskey, the user had a hangover the following morning.”

In some implementations, the presentation operation 2-308 may include an operation 2-714 for presenting a prediction of a future subjective user state resulting from a future objective occurrence associated with the user as depicted in FIG. 2-7a. For instance, the prediction presentation module 2-258 (see FIG. 2-2d) of the computing device 2-10 presenting a prediction of a future subjective user state resulting from a future objective occurrence associated with the user 2-20*. An example prediction might state that “if the user drinks five shots of whiskey tonight, the user will have a hangover tomorrow.”

In some implementations, the presentation operation 2-308 may include an operation 2-716 for presenting a prediction of a future subjective user state resulting from a past objective occurrence associated with the user as depicted in FIG. 2-7a. For instance, the prediction presentation module 2-258 of the computing device 2-10 presenting a prediction of a future subjective user state resulting from a past objective occurrence associated with the user 2-20*. An example prediction might state that “the user will have a hangover tomorrow since the user drank five shots of whiskey tonight.”

In some implementations, the presentation operation 2-308 may include an operation 2-718 for presenting a past subjective user state in connection with a past objective occurrence associated with the user as depicted in FIG. 2-7a. For instance, the past presentation module 2-260 of the computing device 2-10 presenting a past subjective user state in connection with a past objective occurrence associated with the user 2-20*. An example of such a presentation might state that “the user got depressed the last time it rained.”

In some implementations, the presentation operation 2-308 may include an operation 2-720 for presenting a recommendation for a future action as depicted in FIG. 2-7b. For instance, the recommendation module 2-262 (see FIG. 2-2d) of the computing device 2-10 presenting a recommendation for a future action. An example recommendation might state that “the user should not drink five shots of whiskey.”

Operation 2-720 may, in some instances, include an additional operation 2-722 for presenting a justification for the recommendation as depicted in FIG. 2-7b. For instance, the justification module 2-264 (see FIG. 2-2d) of the computing device 2-10 presenting a justification for the recommendation. An example justification might state that “the user should not drink five shots of whiskey because the last time the user drank five shots of whiskey, the user got a hangover.”

In some implementations, the presentation operation 2-308 may include an operation 2-724 for presenting an indication of a strength of correlation between the subjective user state data and the objective occurrence data as depicted in FIG. 2-7b. For instance, the strength of correlation presentation module 2-266 presenting an indication of a strength of correlation between the subjective user state data 2-60 and the objective occurrence data 2-70*.

In some implementations, the presentation operation 2-308 may include an operation 2-726 for presenting one or more results of the correlating in response to a reporting of an occurrence of another objective occurrence associated with the user as depicted in FIG. 2-7b. For instance, the presentation module 2-108 of the computing device 2-10 presenting one or more results of the correlating in response to a reporting of an occurrence of another objective occurrence (e.g., drinking one shot of whiskey) associated with the user 2-20*.

In various implementations, operation 2-726 may further include one or more additional operations. For example, in some implementations, operation 2-726 may include an operation 2-728 for presenting one or more results of the correlating in response to a reporting of an event executed by the user as depicted in FIG. 2-7b. For instance, the presentation module 2-108 of the computing device 2-10 presenting one or more results of the correlating in response to a reporting (e.g., via microblog) of an event (e.g., visiting a bar) executed by the user 2-20*.

In some implementations, operation 2-726 may include an operation 2-730 for presenting one or more results of the correlating in response to a reporting of an event executed by one or more third parties as depicted in FIG. 2-7b. For instance, the presentation module 2-108 of the computing device 2-10 presenting one or more results of the correlating in response to a reporting of an event executed by one or more third parties 2-50 (e.g., third party inviting user to bar).

In some implementations, operation 2-726 may include an operation 2-732 for presenting one or more results of the correlating in response to a reporting of an occurrence of an external event as depicted in FIG. 2-7b. For instance, the presentation module 2-108 of the computing device 2-10 presenting one or more results of the correlating in response to a reporting of an occurrence of an external event (e.g., announcement of new bar opening).

In some implementations, the presentation operation 2-308 of FIG. 2-3 may include an operation 2-734 for presenting one or more results of the correlating in response to a reporting of an occurrence of another subjective user state as depicted in FIG. 2-7b. For instance, the presentation module 2-108 of the computing device 2-10 presenting one or more results of the correlating in response to a reporting of an occurrence of another subjective user state (e.g., hangover). An example presentation might indicate that “the user also had a hangover the last time he drank five shots of whiskey.”

In some implementations, the presentation operation 2-308 may include an operation 2-736 for presenting one or more results of the correlating in response to an inquiry made by the user as depicted in FIG. 2-7b. For instance, the presentation module 2-108 of the computing device 2-10 presenting one or more results of the correlating in response to an inquiry (e.g., why do I have a headache this morning?) made by the user 2-20*.

In some implementations, the presentation operation 2-308 may include an operation 2-738 for presenting one or more results of the correlating in response to an inquiry made by a third party as depicted in FIG. 2-7b. For instance, the presentation module 2-108 of the computing device 2-10 presenting one or more results of the correlating in response to an inquiry (e.g., why is the user lethargic?) made by a third party 2-50.

### IV: Soliciting Data Indicating at Least One Objective Occurrence in Response to Acquisition of Data Indicating at Least One Subjective User State

In the following detailed description, reference is made to the accompanying drawings, which form a part hereof. In the drawings, similar symbols typically identify similar components, unless context dictates otherwise. The illustrative embodiments described in the detailed description, drawings, and claims are not meant to be limiting. Other embodiments may be utilized, and other changes may be made, without departing from the spirit or scope of the subject matter presented here.

A recent trend that is becoming increasingly popular in the computing/communication field is to electronically record one's feelings, thoughts, and other aspects of the person's everyday life onto an open diary. One place where such open diaries are maintained are at social networking sites commonly known as “blogs” where one or more users may report or post their thoughts and opinions on various topics, the latest news, and various other aspects of the users' everyday life. The process of reporting or posting blog entries is commonly referred to as blogging. Other social networking sites may allow users to update their personal information via, for example, social network status reports in which a user may report or post for others to view the latest status or other aspects of the user.

A more recent development in social networking is the introduction and explosive growth of microblogs in which individuals or users (referred to as “microbloggers”) maintain open diaries at microblog websites (e.g., otherwise known as “twitters”) by continuously or semi-continuously posting microblog entries. A microblog entry (e.g., “tweet”) is typically a short text message that is usually not more than 140 characters long. The microblog entries posted by a microblogger may report on any aspect of the microblogger's daily life.

The various things that are typically posted through microblog entries may be categorized into one of at least two possible categories. The first category of things that may be reported through microblog entries are “objective occurrences” associated with the microblogger. Objective occurrences that are associated with a microblogger may be any characteristic, event, happening, or any other aspects associated with or are of interest to the microblogger that can be objectively reported by the microblogger, a third party, or by a device. These things would include, for example, food, medicine, or nutraceutical intake of the microblogger, certain physical characteristics of the microblogger such as blood sugar level or blood pressure that can be objectively measured, daily activities of the microblogger observable by others or by a device, external events that may not be directly related to the user such as the local weather or the performance of the stock market (which the microblogger may have an interest in), activities of others (e.g., spouse or boss) that may directly or indirectly affect the microblogger, and so forth.

A second category of things that may be reported or posted through microblogging entries include “subjective user states” of the microblogger. Subjective user states of a microblogger include any subjective state or status associated with the microblogger that can only be typically reported by the microblogger (e.g., generally cannot be reported by a third party or by a device). Such states including, for example, the subjective mental state of the microblogger (e.g., “I am feeling happy”), the subjective physical states of the microblogger (e.g., “my ankle is sore” or “my ankle does not hurt anymore” or “my vision is blurry”), and the subjective overall state of the microblogger (e.g., “I'm good” or “I'm well”). Note that the term “subjective overall state” as will be used herein refers to those subjective states that may not fit neatly into the other two categories of subjective user states described above (e.g., subjective mental states and subjective physical states). Although microblogs are being used to provide a wealth of personal information, they have thus far been primarily limited to their use as a means for providing commentaries and for maintaining open diaries.

In accordance with various embodiments, methods, systems, and computer program products are provided for, among other things, acquiring subjective user state data including data indicative of at least one subjective user state associated with a user and soliciting, in response to the acquisition of the subjective user state data, objective occurrence data including data indicating at least one objective occurrence. As will be further described herein, in some embodiments, the solicitation of the objective occurrence data may, in addition to be prompted by the acquisition of the subjective user state data, may be prompted by referencing historical data. Such historical data may be historical data that is associated with the user, associated with a group of users, associated with a segment of the general population, or associated with the general population.

The methods, systems, and computer program products may then correlate the subjective user state data (e.g., data that indicate one or more subjective user states of a user) with the objective occurrence data (e.g., data that indicate one or more objective occurrences associated with the user). By correlating the subjective user state data with the objective occurrence data, a causal relationship between one or more objective occurrences (e.g., cause) and one or more subjective user states (e.g., result) associated with a user (e.g., a blogger or microblogger) may be determined in various alternative embodiments. For example, determining that the last time a user ate a banana (e.g., objective occurrence), the user felt “good” (e.g., subjective user state) or determining whenever a user eats a banana the user always or sometimes feels good. Note that an objective occurrence does not need to occur prior to a corresponding subjective user state but instead, may occur subsequent or concurrently with the incidence of the subjective user state. For example, a person may become “gloomy” (e.g., subjective user state) whenever it is about to rain (e.g., objective occurrence) or a person may become gloomy while (e.g., concurrently) it is raining.

As briefly described above, a “subjective user state” is in reference to any state or status associated with a user (e.g., a blogger or microblogger) at any moment or interval in time that only the user can typically indicate or describe. Such states include, for example, the subjective mental state of the user (e.g., user is feeling sad), the subjective physical state (e.g., physical characteristic) of the user that only the user can typically indicate (e.g., a backache or an easing of a backache as opposed to blood pressure which can be reported by a blood pressure device and/or a third party), and the subjective overall state of the user (e.g., user is “good”). Examples of subjective mental states include, for example, happiness, sadness, depression, anger, frustration, elation, fear, alertness, sleepiness, and so forth. Examples of subjective physical states include, for example, the presence, easing, or absence of pain, blurry vision, hearing loss, upset stomach, physical exhaustion, and so forth. Subjective overall states may include any subjective user states that cannot be easily categorized as a subjective mental state or as a subjective physical state. Examples of overall states of a user that may be subjective user states include, for example, the user being good, bad, exhausted, lack of rest, wellness, and so forth.

In contrast, “objective occurrence data,” which may also be referred to as “objective context data,” may include data that indicate one or more objective occurrences associated with the user that occurred at particular intervals or points in time. An objective occurrence may be any physical characteristic, event, happenings, or any other aspect that may be associated with or is of interest to a user that can be objectively reported by at least a third party or a sensor device. Note, however, that such objective occurrence data does not have to be actually provided by a sensor device or by a third party, but instead, may be reported by the user himself or herself (e.g., via microblog entries). Examples of objectively reported occurrences that could be indicated by the objective occurrence data include, for example, a user's food, medicine, or nutraceutical intake, the user's location at any given point in time, a user's exercise routine, a user's physiological characteristics such as blood pressure, social or professional activities, the weather at a user's location, activities associated with third parties, occurrence of external events such as the performance of the stock market, and so forth.

The term “correlating” as will be used herein is in reference to a determination of one or more relationships between at least two variables. Alternatively, the term “correlating” may merely be in reference to the linking or associating of at least two variables. In the following exemplary embodiments, the first variable is subjective user state data that represents at least one subjective user state of a user and the second variable is objective occurrence data that represents at least one objective occurrence. In embodiments where the subjective user state data includes data that indicates multiple subjective user states, each of the subjective user states represented by the subjective user state data may be the same or similar type of subjective user state (e.g., user being happy) at different intervals or points in time. Alternatively, different types of subjective user state (e.g., user being happy and user being sad) may be represented by the subjective user state data. Similarly, in embodiments where multiple objective occurrences are indicated by the objective occurrence data, each of the objective occurrences may represent the same or similar type of objective occurrence (e.g., user exercising) at different intervals or points in time, or alternatively, different types of objective occurrence (e.g., user exercising and user resting).

Various techniques may be employed for correlating subjective user state data with objective occurrence data in various alternative embodiments. For example, in some embodiments, correlating the objective occurrence data with the subjective user state data may be accomplished by determining a sequential pattern associated with at least one subjective user state indicated by the subjective user state data and at least one objective occurrence indicated by the objective occurrence data. In other embodiments, correlating of the objective occurrence data with the subjective user state data may involve determining multiple sequential patterns associated with multiple subjective user states and multiple objective occurrences.

A sequential pattern, as will be described herein, may define time and/or temporal relationships between two or more events (e.g., one or more subjective user states and one or more objective occurrences). In order to determine a sequential pattern, objective occurrence data including data indicating at least one objective occurrence may be solicited (e.g., from a user, from one or more third party sources, or from one or more sensor devices) in response to an acquisition of subjective user state data including data indicating at least one subjective user state.

For example, if a user reports that the user felt gloomy on a particular day (e.g., subjective user state) then a solicitation (e.g., from the user or from a third party source such as a content provider) may be made about the local weather (e.g., objective occurrence). Such solicitation of objective occurrence data may be prompted based, at least in part, on the reporting of the subjective user state and based on historical data such as historical data that indicates or suggests that the user tends to get gloomy when the weather is bad (e.g., cloudy) or based on historical data that indicates that people in the general population tend to get gloomy whenever the weather is bad. In some embodiments, such historical data may indicate or define one or more historical sequential patterns of the user or of the general population as they relate to subjective user states and objective occurrences.

As briefly described above, a sequential pattern may merely indicate or represent the temporal relationship or relationships between at least one subjective user state and at least one objective occurrence (e.g., whether the incidence or occurrence of the at least one subjective user state occurred before, after, or at least partially concurrently with the incidence of the at least one objective occurrence). In alternative implementations, and as will be further described herein, a sequential pattern may indicate a more specific time relationship between the incidences of one or more subjective user states and the incidences of one or more objective occurrences. For example, a sequential pattern may represent the specific pattern of events (e.g., one or more objective occurrences and one or more subjective user states) that occurs along a timeline.

The following illustrative example is provided to describe how a sequential pattern associated with at least one subjective user state and at least one objective occurrence may be determined based, at least in part, on the temporal relationship between the incidence of the at least one subjective user state and the incidence of the at least one objective occurrence in accordance with some embodiments. For these embodiments, the determination of a sequential pattern may initially involve determining whether the incidence of the at least one subjective user state occurred within some predefined time increments of the incidence of the one objective occurrence. That is, it may be possible to infer that those subjective user states that did not occur within a certain time period from the incidence of an objective occurrence are not related or are unlikely related to the incidence of that objective occurrence.

For example, suppose a user during the course of a day eats a banana and also has a stomach ache sometime during the course of the day. If the consumption of the banana occurred in the early morning hours but the stomach ache did not occur until late that night, then the stomach ache may be unrelated to the consumption of the banana and may be disregarded. On the other hand, if the stomach ache had occurred within some predefined time increment, such as within 2 hours of consumption of the banana, then it may be concluded that there is a correlation or link between the stomach ache and the consumption of the banana. If so, a temporal relationship between the consumption of the banana and the occurrence of the stomach ache may be determined. Such a temporal relationship may be represented by a sequential pattern. Such a sequential pattern may simply indicate that the stomach ache (e.g., a subjective user state) occurred after (rather than before or concurrently) the consumption of banana (e.g., an objective occurrence).

As will be further described herein, other factors may also be referenced and examined in order to determine a sequential pattern and whether there is a relationship (e.g., causal relationship) between an objective occurrence and a subjective user state. These factors may include, for example, historical data (e.g., historical medical data such as genetic data or past history of the user or historical data related to the general population regarding, for example, stomach aches and bananas) as briefly described above. Alternatively, a sequential pattern may be determined for multiple subjective user states and multiple objective occurrences. Such a sequential pattern may particularly map the exact temporal or time sequencing of the various events (e.g., subjective user states and/or objective occurrences). The determined sequential pattern may then be used to provide useful information to the user and/or third parties.

The following is another illustrative example of how subjective user state data may be correlated with objective occurrence data by determining multiple sequential patterns and comparing the sequential patterns with each other. Suppose, for example, a user such as a microblogger reports that the user ate a banana on a Monday. The consumption of the banana, in this example, is a reported first objective occurrence associated with the user. The user then reports that 15 minutes after eating the banana, the user felt very happy. The reporting of the emotional state (e.g., felt very happy) is, in this example, a reported first subjective user state. Thus, the reported incidence of the first objective occurrence (e.g., eating the banana) and the reported incidence of the first subjective user state (user felt very happy) on Monday may be represented by a first sequential pattern.

On Tuesday, the user reports that the user ate another banana (e.g., a second objective occurrence associated with the user). The user then reports that 20 minutes after eating the second banana, the user felt somewhat happy (e.g., a second subjective user state). Thus, the reported incidence of the second objective occurrence (e.g., eating the second banana) and the reported incidence of the second subjective user state (user felt somewhat happy) on Tuesday may be represented by a second sequential pattern. Note that in this example, the occurrences of the first subjective user state and the second subjective user state may be indicated by subjective user state data while the occurrences of the first objective occurrence and the second objective occurrence may be indicated by objective occurrence data.

In a slight variation of the above example, suppose the user had forgotten to report for Tuesday the consumption of the banana but does report feeling somewhat happy on Tuesday. This may result in the user being asked, based on the reporting of the user feeling somewhat happy on Tuesday, as to whether the user ate anything prior to feeling somewhat happy or whether the user ate a banana prior to feeling somewhat happy. Asking of such questions may be prompted both in response to the reporting of the user feeling somewhat happy on Tuesday and on referencing historical data (e.g., first sequential pattern derived from Monday's consumption of banana and feeling happy). Upon the user confirming the consumption of the banana on Tuesday, a second sequential pattern may be determined.

In any event, by comparing the first sequential pattern with the second sequential pattern, the subjective user state data may be correlated with the objective occurrence data. In some implementations, the comparison of the first sequential pattern with the second sequential pattern may involve trying to match the first sequential pattern with the second sequential pattern by examining certain attributes and/or metrics. For example, comparing the first subjective user state (e.g., user felt very happy) of the first sequential pattern with the second subjective user state (e.g., user felt somewhat happy) of the second sequential pattern to see if they at least substantially match or are contrasting (e.g., being very happy in contrast to being slightly happy or being happy in contrast to being sad). Similarly, comparing the first objective occurrence (e.g., eating a banana) of the first sequential pattern may be compared to the second objective occurrence (e.g., eating of another banana) of the second sequential pattern to determine whether they at least substantially match or are contrasting.

A comparison may also be made to determine if the extent of time difference (e.g., 15 minutes) between the first subjective user state (e.g., user being very happy) and the first objective occurrence (e.g., user eating a banana) matches or are at least similar to the extent of time difference (e.g., 20 minutes) between the second subjective user state (e.g., user being somewhat happy) and the second objective occurrence (e.g., user eating another banana). These comparisons may be made in order to determine whether the first sequential pattern matches the second sequential pattern. A match or substantial match would suggest, for example, that a subjective user state (e.g., happiness) is linked to a particular objective occurrence (e.g., consumption of banana).

As briefly described above, the comparison of the first sequential pattern with the second sequential pattern may include a determination as to whether, for example, the respective subjective user states and the respective objective occurrences of the sequential patterns are contrasting subjective user states and/or contrasting objective occurrences. For example, suppose in the above example the user had reported that the user had eaten a whole banana on Monday and felt very energetic (e.g., first subjective user state) after eating the whole banana (e.g., first objective occurrence). Suppose that the user also reported that on Tuesday he ate a half a banana instead of a whole banana and only felt slightly energetic (e.g., second subjective user state) after eating the half banana (e.g., second objective occurrence). In this scenario, the first sequential pattern (e.g., feeling very energetic after eating a whole banana) may be compared to the second sequential pattern (e.g., feeling slightly energetic after eating only a half of a banana) to at least determine whether the first subjective user state (e.g., being very energetic) and the second subjective user state (e.g., being slightly energetic) are contrasting subjective user states. Another determination may also be made during the comparison to determine whether the first objective occurrence (eating a whole banana) is in contrast with the second objective occurrence (e.g., eating a half of a banana).

In doing so, an inference may be made that eating a whole banana instead of eating only a half of a banana makes the user happier or eating more banana makes the user happier. Thus, the word “contrasting” as used here with respect to subjective user states refers to subjective user states that are the same type of subjective user states (e.g., the subjective user states being variations of a particular type of subjective user states such as variations of subjective mental states). Thus, for example, the first subjective user state and the second subjective user state in the previous illustrative example are merely variations of subjective mental states (e.g., happiness). Similarly, the use of the word “contrasting” as used here with respect to objective occurrences refers to objective states that are the same type of objective occurrences (e.g., consumption of food such as banana).

As those skilled in the art will recognize, a stronger correlation between the subjective user state data and the objective occurrence data could be obtained if a greater number of sequential patterns (e.g., if there was a third sequential pattern, a fourth sequential pattern, and so forth, that indicated that the user became happy or happier whenever the user ate bananas) are used as a basis for the correlation. Note that for ease of explanation and illustration, each of the exemplary sequential patterns to be described herein will be depicted as a sequential pattern of an occurrence of a single subjective user state and an occurrence of a single objective occurrence. However, those skilled in the art will recognize that a sequential pattern, as will be described herein, may also be associated with occurrences of multiple objective occurrences and/or multiple subjective user states. For example, suppose the user had reported that after eating a banana, he had gulped down a can of soda. The user then reported that he became happy but had an upset stomach. In this example, the sequential pattern associated with this scenario will be associated with two objective occurrences (e.g., eating a banana and drinking a can of soda) and two subjective user states (e.g., user having an upset stomach and feeling happy).

In some embodiments, and as briefly described earlier, the sequential patterns derived from subjective user state data and objective occurrence data may be based on temporal relationships between objective occurrences and subjective user states. For example, whether a subjective user state occurred before, after, or at least partially concurrently with an objective occurrence. For instance, a plurality of sequential patterns derived from subjective user state data and objective occurrence data may indicate that a user always has a stomach ache (e.g., subjective user state) after eating a banana (e.g., first objective occurrence).

FIGS. 3-1a and 3-1b illustrate an example environment in accordance with various embodiments. In the illustrated environment, an exemplary system 3-100 may include at least a computing device 3-10 (see FIG. 3-1b) that may be employed in order to, among other things, acquire subjective user state data 3-60 associated with a user 3-20*, solicit and acquire objective occurrence data 3-70* in response to the acquisition of the subjective user state data 3-60, and to correlate the subjective user state data 3-60 with the objective occurrence data 3-70*. Note that in the following, “*” indicates a wildcard. Thus, user 3-20* may indicate a user 3-20a or a user 3-20b of FIGS. 3-1a and 3-1b.

In some embodiments, the computing device 3-10 may be a network server in which case the computing device 3-10 may communicate with a user 3-20a via a mobile device 3-30 and through a wireless and/or wired network 3-40. A network server, as will be described herein, may be in reference to a server located at a single network site or located across multiple network sites or a conglomeration of servers located at multiple network sites. The mobile device 3-30 may be a variety of computing/communication devices including, for example, a cellular phone, a personal digital assistant (PDA), a laptop, a desktop, or other types of computing/communication device that can communicate with the computing device 3-10.

In alternative embodiments, the computing device 3-10 may be a local computing device that communicates directly with a user 3-20b. For these embodiments, the computing device 3-10 may be any type of handheld device such as a cellular telephone, a PDA, or other types of computing/communication devices such as a laptop computer, a desktop computer, and so forth. In various embodiments, the computing device 3-10 may be a peer-to-peer network component device. In some embodiments, the computing device 3-10 may operate via a web 2.0 construct.

In embodiments where the computing device 3-10 is a server, the computing device 3-10 may obtain the subjective user state data 3-60 indirectly from a user 3-20a via a network interface 3-120. In alternative embodiments in which the computing device 3-10 is a local device such as a handheld device (e.g., cellular telephone, personal digital assistant, etc.), the subjective user state data 3-60 may be directly obtained from a user 3-20b via a user interface 3-122. As will be further described, the computing device 3-10 may acquire the objective occurrence data 3-70* from one or more alternative sources.

For ease of illustration and explanation, the following systems and operations to be described herein will be generally described in the context of the computing device 3-10 being a network server. However, those skilled in the art will recognize that these systems and operations may also be implemented when the computing device 3-10 is a local device such as a handheld device that may communicate directly with a user 3-20b.

Assuming that the computing device 3-10 is a server, the computing device 3-10, in various implementations, may be configured to acquire subjective user state data 3-60 including data indicating at least one subjective user state 3-60a via the mobile device 3-30 and through wireless and/or wired networks 3-40. In some implementations, the subjective user state data 3-60 may further include additional data that may indicate one or more additional subjective user states (e.g., data indicating at least a second subjective user state 3-60b).

In various embodiments, the data indicating the at least one subjective user state 3-60a, as well as the data indicating the at least second subjective user state 3-60b, may be in the form of blog entries, such as microblog entries, status reports (e.g., social networking status reports), electronic messages (email, text messages, instant messages, etc.) or other types of electronic messages or documents. The data indicating the at least one subjective user state 3-60a and the data indicating the at least second subjective user state 3-60b may, in some instances, indicate the same, contrasting, or completely different subjective user states.

Examples of subjective user states that may be indicated by the subjective user state data 3-60 include, for example, subjective mental states of the user 3-20a (e.g., user 3-20a is sad or angry), subjective physical states of the user 3-20a (e.g., physical or physiological characteristic of the user 3-20a such as the presence, absence, elevating, or easing of a stomach ache or headache), subjective overall states of the user 3-20a (e.g., user 3-20a is “well”), and/or other subjective user states that only the user 3-20a can typically indicate.

The computing device 3-10 may also be configured to solicit objective occurrence data 3-70* including data indicating at least one objective occurrence. Such a solicitation of the objective occurrence data 3-70* may be prompted in response to the acquisition of subjective user state data 3-60 and/or in response to referencing of historical data 3-72 as will be further described herein. The solicitation of objective occurrence data 3-70* may be made through a network interface 3-120 or through the user interface 3-122. As will be further described, the solicitation of the objective occurrence data 3-70* from a source (e.g., the user 3-20*, one or more third party sources, or one or more sensors 3-35) may be accomplished in a number of ways depending on the specific circumstances (e.g., whether the computing device 3-10 is a server or a local device and whether the source is the user 3-20*, one or more third parties 3-50, or one or more sensors 3-35). Examples of how objective occurrence data 3-70* could be solicited include, for example, transmitting via a network interface 3-120 a request for objective occurrence data 3-70*, indicating via a user interface 3-122 a request for objective occurrence data 3-70*, configurating or activating one or more sensors 3-35 to collect and provide objective occurrence data 3-70b, and so forth.

After soliciting for the objective occurrence data 3-70*, the computing device 3-10 may be configured to acquire the objective occurrence data 3-70* from one or more sources. In various embodiments, the objective occurrence data 3-70* acquired by the computing device 3-10 may include data indicative of at least one objective occurrence associated with a user 3-20a (or with user 3-20b in the case where the computing device 3-10 is a local device). The objective occurrence data 3-70* may additionally include data indicative of one or more additional objective occurrences associated with the user 3-20a (or user 3-20b) including data indicating at least a second objective occurrence associated with the user 3-20a (or user 3-20b). In some embodiments, objective occurrence data 3-70a may be acquired from one or more third parties 3-50. Examples of third parties 3-50 include, for example, other users (not depicted), a healthcare provider, a hospital, a place of employment, a content provider, and so forth.

In some embodiments, objective occurrence data 3-70b may be acquired from one or more sensors 3-35 that may be designed for sensing or monitoring various aspects associated with the user 3-20a (or user 3-20b). For example, in some implementations, the one or more sensors 3-35 may include a global positioning system (GPS) device for determining the location of the user 3-20a and/or a physical activity sensor for measuring physical activities of the user 3-20a. Examples of a physical activity sensor include, for example, a pedometer for measuring physical activities of the user 3-20a. In certain implementations, the one or more sensors 3-35 may include one or more physiological sensor devices for measuring physiological characteristics of the user 3-20a. Examples of physiological sensor devices include, for example, a blood pressure monitor, a heart rate monitor, a glucometer, and so forth. In some implementations, the one or more sensors 3-35 may include one or more image capturing devices such as a video or digital camera.

In some embodiments, objective occurrence data 3-70c may be acquired from the user 3-20a via the mobile device 3-30 (or from user 3-20b via user interface 3-122). For these embodiments, the objective occurrence data 3-70c may be in the form of blog entries (e.g., microblog entries), status reports, or other types of electronic entries or messages. In various implementations, the objective occurrence data 3-70c acquired from the user 3-20a may indicate, for example, activities (e.g., exercise or food or medicine intake) performed by the user 3-20a, certain physical characteristics (e.g., blood pressure or location) associated with the user 3-20a, or other aspects associated with the user 3-20a that the user 3-20a can report objectively. The objective occurrence data 3-70c may be in the form of a text data, audio or voice data, or image data.

After acquiring the subjective user state data 3-60 and the objective occurrence data 3-70*, the computing device 3-10 may be configured to correlate the acquired subjective user data 3-60 with the acquired objective occurrence data 3-70* by, for example, determining whether there is a sequential relationship between the one or more subjective user states as indicated by the acquired subjective user state data 3-60 and the one or more objective occurrences indicated by the acquired objective occurrence data 3-70*.

In some embodiments, and as will be further indicated in the operations and processes to be described herein, the computing device 3-10 may be further configured to present one or more results of correlation. In various embodiments, the one or more correlation results 3-80 may be presented to the user 3-20a and/or to one or more third parties 3-50 in various forms (e.g., in the form of an advisory, a warning, a prediction, and so forth). The one or more third parties 3-50 may be other users 3-20* such as other microbloggers, a health care provider, advertisers, and/or content providers.

As illustrated in FIG. 3-1b, computing device 3-10 may include one or more components and/or sub-modules. For instance, in various embodiments, computing device 3-10 may include a subjective user state data acquisition module 3-102, an objective occurrence data solicitation module 3-103, an objective occurrence data acquisition module 3-104, a correlation module 3-106, a presentation module 3-108, a network interface 3-120 (e.g., network interface card or NIC), a user interface 3-122 (e.g., a display monitor, a touchscreen, a keypad or keyboard, a mouse, an audio system including a microphone and/or speakers, an image capturing system including digital and/or video camera, and/or other types of interface devices), one or more applications 3-126 (e.g., a web 2.0 application, a voice recognition application, and/or other applications), and/or memory 3-140, which may include historical data 3-72.

FIG. 3-2a illustrates particular implementations of the subjective user state data acquisition module 3-102 of the computing device 3-10 of FIG. 3-1b. In brief, the subjective user state data acquisition module 3-102 may be designed to, among other things, acquire subjective user state data 3-60 including data indicating at least one subjective user state 3-60a. As further illustrated, the subjective user state data acquisition module 3-102 may include a subjective user state data reception module 3-202 for receiving the subjective user state data 3-60 from a user 3-20a via the network interface 3-120 (e.g., in the case where the computing device 3-10 is a network server). Alternatively, the subjective user state data reception module 3-202 may receive the subjective user state data 3-60 directly from a user 3-20b (e.g., in the case where the computing device 3-10 is a local device) via the user interface 3-122.

In some implementations, the subjective user state data reception module 3-202 may further include a user interface data reception module 3-204 and/or a network interface data reception module 3-206. In brief, and as will be further described in the processes and operations to be described herein, the user interface data reception module 3-204 may be configured to acquire subjective user state data 3-60 via a user interface 3-122 (e.g., a display monitor, a keyboard, a touch screen, a mouse, a keypad, a microphone, a camera, and/or other interface devices) such as in the case where the computing device 3-10 is a local device to be used directly by a user 3-20b. In contrast, the network interface data reception module 3-206 may be configured to acquire subjective user state data 3-60 from a wireless and/or wired network 3-40 via a network interface 3-120 (e.g., network interface card or NIC) such as in the case where the computing device 3-10 is a network server.

In various embodiments, the subjective user state data acquisition module 3-102 may include a time data acquisition module 3-208 for acquiring time and/or temporal elements associated with one or more subjective user states of a user 3-20*. For these embodiments, the time and/or temporal elements (e.g., time stamps, time interval indicators, and/or temporal relationship indicators) acquired by the time data acquisition module 3-208 may be useful for, among other things, determining one or more sequential patterns associated with subjective user states and objective occurrences as will be further described herein. In some implementations, the time data acquisition module 3-208 may include a time stamp acquisition module 3-210 for acquiring (e.g., either by receiving or generating) one or more time stamps associated with one or more subjective user states. In the same or different implementations, the time data acquisition module 3-208 may include a time interval acquisition module 3-212 for acquiring (e.g., either by receiving or generating) indications of one or more time intervals associated with one or more subjective user states. In the same or different implementations, the time data acquisition module 3-208 may include a temporal relationship acquisition module 3-214 for acquiring, for example, indications of temporal relationships between subjective user states and objective occurrences. For example, acquiring an indication that a subjective user state such as a stomach ache occurred before, after, or at least partially concurrently with incidence of an objective occurrence such as eating lunch or the time being noon.

FIG. 3-2b illustrates particular implementations of the objective occurrence data solicitation module 3-103 of the computing device 3-10 of FIG. 3-1b. The objective occurrence data solicitation module 3-103 may be configured or designed to solicit, in response to acquisition of subjective user state data 3-60 including data indicating at least subjective user state 3-60a, objective occurrence data 3-70* including data indicating at least one objective occurrence. The objective occurrence data 3-70* to be solicited may be requested from a user 3-20*, from one or more third parties 3-50 (e.g., third party sources such as other users (not depicted), content providers, healthcare entities including doctor's or dentist offices and hospitals, and so forth), or may be solicited from one or more sensors 3-35. The solicitation may be made via, for example, network interface 3-120 or via the user interface 3-122 in the case where user 3-20b is the source for the objective occurrence data 3-70*.

In various embodiments, the objective occurrence data solicitation module 3-103 may be configured to solicit data indicating occurrence of at least one objective occurrence that occurred at a specified point in time or occurred at a specified time interval. In some implementations, the solicitation of the objective occurrence data 3-70* by the objective occurrence data solicitation module 3-103 may be prompted by the acquisition of subjective user state data 3-60 including data indicating at least one subjective user state 3-60a and/or as a result of referencing historical data 3-72 (which may be stored in memory 3-140). Historical data 3-72, in some instances, may prompt solicitation of particular data indicating occurrence of a particular or a particular type of objective occurrence. In some implementations, the historical data 3-72 to be referenced may be historical data 3-72 indicative of a link between a subjective user state type and an objective occurrence type. In the same or different implementations, the historical data 3-72 to be referenced may include one or more historical sequential patterns associated with the user 3-20*, a group of users, or the general population. In the same or different implementations, the historical data 3-72 to be referenced may include historical medical data associated with the user 3-20*, associated with other users, or associated with the general population. The relevance of the historical data 3-72 with respect to the solicitation operations performed by the objective occurrence data solicitation module 3-103 will be apparent in the processes and operations to be described herein.

In order to perform the various functions described herein, the objective occurrence data solicitation module 3-103 may include a network interface solicitation module 3-215, a user interface solicitation module 3-216, a requesting module 3-217, a configuration module 3-218, and/or a directing/instructing module 3-219. In brief, the network interface solicitation module 3-215 may be employed in order to solicit objective occurrence data 3-70* via a network interface 3-120. The user interface solicitation module 3-216 may be employed in order to, among other things, solicit objective occurrence data 3-70* via user interface 3-122 from, for example, a user 3-20b. The requesting module 3-217 may be employed in order to request the objective occurrence data 3-70a and 3-70b from a user 3-20* or from one or more third parties 3-50. The configuration module 3-218 may be employed in order to configure one or more sensors 3-35 to collect and provide objective occurrence data 3-70b. The directing/instructing module 3-219 may be employed in order to direct and/or instruct the one or more sensors 3-35 to collect and provide objective occurrence data 3-70b.

Referring now to FIG. 3-2c illustrating particular implementations of the objective occurrence data acquisition module 3-104 of the computing device 3-10 of FIG. 3-1b. In various implementations, the objective occurrence data acquisition module 3-104 may be configured to acquire (e.g., receive from a user 3-20*, receive from one or more third parties 3-50, or receive from one or more sensors 3-35) objective occurrence data 3-70* including data indicative of one or more objective occurrences that may be associated with a user 3-20*. In various embodiments, the objective occurrence data acquisition module 3-104 may include a reception module 3-224 configured to receive objective occurrence data 3-70*. In some embodiments, the reception module 3-224 may further include an objective occurrence data user interface reception module 3-226 for receiving, via a user interface 3-122, objective occurrence data 3-70* including data indicating at least one objective occurrence from a user 3-20b. In the same or different embodiments, the reception module 3-224 may include an objective occurrence data network interface reception module 3-227 for receiving, via a network interface 3-120, objective occurrence data including data indicating at least one objective occurrence from a user 3-20b, from one or more third parties 3-50, or from one or more sensors 3-35.

In various embodiments, the objective occurrence data acquisition module 3-104 may include a time data acquisition module 3-228 configured to acquire (e.g., receive or generate) time and/or temporal elements associated with one or more objective occurrences. For these embodiments, the time and/or temporal elements (e.g., time stamps, time intervals, and/or temporal relationships) may be useful for determining sequential patterns associated with objective occurrences and subjective user states.

In some implementations, the time data acquisition module 3-228 may include a time stamp acquisition module 3-230 for acquiring (e.g., either by receiving or by generating) one or more time stamps associated with one or more objective occurrences associated with a user 3-20*. In the same or different implementations, the time data acquisition module 3-228 may include a time interval acquisition module 3-231 for acquiring (e.g., either by receiving or generating) indications of one or more time intervals associated with one or more objective occurrences. In the same or different implementations, the time data acquisition module 3-228 may include a temporal relationship acquisition module 3-232 for acquiring indications of temporal relationships between objective occurrences and subjective user states (e.g., an indication that an objective occurrence occurred before, after, or at least partially concurrently with incidence of a subjective user state).

Turning now to FIG. 3-2d illustrating particular implementations of the correlation module 3-106 of the computing device 3-10 of FIG. 3-1b. The correlation module 3-106 may be configured to, among other things, correlate subjective user state data 3-60 with objective occurrence data 3-70* based, at least in part, on a determination of at least one sequential pattern of at least one objective occurrence and at least one subjective user state. In various embodiments, the correlation module 3-106 may include a sequential pattern determination module 3-236 configured to determine one or more sequential patterns of one or more subjective user states and one or more objective occurrences.

The sequential pattern determination module 3-236, in various implementations, may include one or more sub-modules that may facilitate in the determination of one or more sequential patterns. As depicted, the one or more sub-modules that may be included in the sequential pattern determination module 3-236 may include, for example, a “within predefined time increment determination” module 3-238, a temporal relationship determination module 3-239, a subjective user state and objective occurrence time difference determination module 3-240, and/or a historical data referencing module 3-241. In brief, the within predefined time increment determination module 3-238 may be configured to determine whether at least one subjective user state of a user 3-20* occurred within a predefined time increment from an incidence of at least one objective occurrence. For example, determining whether a user 3-20* feeling “bad” (i.e., a subjective user state) occurred within ten hours (i.e., predefined time increment) of eating a large chocolate sundae (i.e., an objective occurrence). Such a process may be used in order to filter out events that are likely not related or to facilitate in determining the strength of correlation between subjective user state data 3-60 and objective occurrence data 3-70*.

The temporal relationship determination module 3-239 may be configured to determine the temporal relationships between one or more subjective user states and one or more objective occurrences. For example, this may entail determining whether a particular subjective user state (e.g., sore back) occurred before, after, or at least partially concurrently with incidence of an objective occurrence (e.g., sub-freezing temperature).

The subjective user state and objective occurrence time difference determination module 3-240 may be configured to determine the extent of time difference between the incidence of at least one subjective user state and the incidence of at least one objective occurrence. For example, determining how long after taking a particular brand of medication (e.g., objective occurrence) did a user 3-20* feel “good” (e.g., subjective user state).

The historical data referencing module 3-241 may be configured to reference historical data 3-72 in order to facilitate in determining sequential patterns. For example, in various implementations, the historical data 3-72 that may be referenced may include, for example, general population trends (e.g., people having a tendency to have a hangover after drinking or ibuprofen being more effective than aspirin for toothaches in the general population), medical information such as genetic, metabolome, or proteome information related to the user 3-20* (e.g., genetic information of the user 3-20* indicating that the user 3-20* is susceptible to a particular subjective user state in response to occurrence of a particular objective occurrence), or historical sequential patterns such as known sequential patterns of the general population or of the user 3-20* (e.g., people tending to have difficulty sleeping within five hours after consumption of coffee). In some instances, such historical data 3-72 may be useful in associating one or more subjective user states with one or more objective occurrences.

In some embodiments, the correlation module 3-106 may include a sequential pattern comparison module 3-242. As will be further described herein, the sequential pattern comparison module 3-242 may be configured to compare two or more sequential patterns with each other to determine, for example, whether the sequential patterns at least substantially match each other or to determine whether the sequential patterns are contrasting sequential patterns.

As depicted in FIG. 3-2d, in various implementations, the sequential pattern comparison module 3-242 may further include one or more sub-modules that may be employed in order to, for example, facilitate in the comparison of different sequential patterns. For example, in various implementations, the sequential pattern comparison module 3-242 may include one or more of a subjective user state equivalence determination module 3-243, an objective occurrence equivalence determination module 3-244, a subjective user state contrast determination module 3-245, an objective occurrence contrast determination module 3-246, a temporal relationship comparison module 3-247, and/or an extent of time difference comparison module 3-248.

The subjective user state equivalence determination module 3-243 may be configured to determine whether subjective user states associated with different sequential patterns are equivalent. For example, the subjective user state equivalence determination module 3-243 may determine whether a first subjective user state of a first sequential pattern is equivalent to a second subjective user state of a second sequential pattern. For instance, suppose a user 3-20* reports that on Monday he had a stomach ache (e.g., first subjective user state) after eating at a particular restaurant (e.g., a first objective occurrence), and suppose further that the user 3-20* again reports having a stomach ache (e.g., a second subjective user state) after eating at the same restaurant (e.g., a second objective occurrence) on Tuesday, then the subjective user state equivalence determination module 3-243 may be employed in order to compare the first subjective user state (e.g., stomach ache) with the second subjective user state (e.g., stomach ache) to determine whether they are equivalent.

In contrast, the objective occurrence equivalence determination module 3-244 may be configured to determine whether objective occurrences of different sequential patterns are equivalent. For example, the objective occurrence equivalence determination module 3-244 may determine whether a first objective occurrence of a first sequential pattern is equivalent to a second objective occurrence of a second sequential pattern. For instance, for the above example the objective occurrence equivalence determination module 3-244 may compare eating at the particular restaurant on Monday (e.g., first objective occurrence) with eating at the same restaurant on Tuesday (e.g., second objective occurrence) in order to determine whether the first objective occurrence is equivalent to the second objective occurrence.

In some implementations, the sequential pattern comparison module 3-242 may include a subjective user state contrast determination module 3-245 that may be configured to determine whether subjective user states associated with different sequential patterns are contrasting subjective user states. For example, the subjective user state contrast determination module 3-245 may determine whether a first subjective user state of a first sequential pattern is a contrasting subjective user state from a second subjective user state of a second sequential pattern. To illustrate, suppose a user 3-20* reports that he felt very “good” (e.g., first subjective user state) after jogging for an hour (e.g., first objective occurrence) on Monday, but reports that he felt “bad” (e.g., second subjective user state) when he did not exercise (e.g., second objective occurrence) on Tuesday, then the subjective user state contrast determination module 3-245 may compare the first subjective user state (e.g., feeling good) with the second subjective user state (e.g., feeling bad) to determine that they are contrasting subjective user states.

In some implementations, the sequential pattern comparison module 3-242 may include an objective occurrence contrast determination module 3-246 that may be configured to determine whether objective occurrences of different sequential patterns are contrasting objective occurrences. For example, the objective occurrence contrast determination module 3-246 may determine whether a first objective occurrence of a first sequential pattern is a contrasting objective occurrence from a second objective occurrence of a second sequential pattern. For instance, for the above example, the objective occurrence contrast determination module 3-246 may compare the “jogging” on Monday (e.g., first objective occurrence) with the “no jogging” on Tuesday (e.g., second objective occurrence) in order to determine whether the first objective occurrence is a contrasting objective occurrence from the second objective occurrence. Based on the contrast determination, an inference may be made that the user 3-20* may feel better by jogging rather than by not jogging at all.

In some embodiments, the sequential pattern comparison module 3-242 may include a temporal relationship comparison module 3-247 that may be configured to make comparisons between different temporal relationships of different sequential patterns. For example, the temporal relationship comparison module 3-247 may compare a first temporal relationship between a first subjective user state and a first objective occurrence of a first sequential pattern with a second temporal relationship between a second subjective user state and a second objective occurrence of a second sequential pattern in order to determine whether the first temporal relationship at least substantially matches the second temporal relationship.

For example, suppose in the above example the user 3-20* eating at the particular restaurant (e.g., first objective occurrence) and the subsequent stomach ache (e.g., first subjective user state) on Monday represents a first sequential pattern while the user 3-20* eating at the same restaurant (e.g., second objective occurrence) and the subsequent stomach ache (e.g., second subjective user state) on Tuesday represents a second sequential pattern. In this example, the occurrence of the stomach ache after (rather than before or concurrently) eating at the particular restaurant on Monday represents a first temporal relationship associated with the first sequential pattern while the occurrence of a second stomach ache after (rather than before or concurrently) eating at the same restaurant on Tuesday represents a second temporal relationship associated with the second sequential pattern. Under such circumstances, the temporal relationship comparison module 3-247 may compare the first temporal relationship to the second temporal relationship in order to determine whether the first temporal relationship and the second temporal relationship at least substantially match (e.g., stomachaches in both temporal relationships occurring after eating at the restaurant). Such a match may result in the inference that a stomach ache is associated with eating at the particular restaurant.

In some implementations, the sequential pattern comparison module 3-242 may include an extent of time difference comparison module 3-248 that may be configured to compare the extent of time differences between incidences of subjective user states and incidences of objective occurrences of different sequential patterns. For example, the extent of time difference comparison module 3-248 may compare the extent of time difference between incidence of a first subjective user state and incidence of a first objective occurrence of a first sequential pattern with the extent of time difference between incidence of a second subjective user state and incidence of a second objective occurrence of a second sequential pattern. In some implementations, the comparisons may be made in order to determine that the extent of time differences of the different sequential patterns at least substantially or proximately match.

In some embodiments, the correlation module 3-106 may include a strength of correlation determination module 3-250 for determining a strength of correlation between subjective user state data 3-60 and objective occurrence data 3-70* associated with a user 3-20*. In some implementations, the strength of correlation may be determined based, at least in part, on the results provided by the other sub-modules of the correlation module 3-106 (e.g., the sequential pattern determination module 3-236, the sequential pattern comparison module 3-242, and their sub-modules).

FIG. 3-2e illustrates particular implementations of the presentation module 3-108 of the computing device 3-10 of FIG. 3-1b. In various implementations, the presentation module 3-108 may be configured to present, for example, one or more results of the correlation operations performed by the correlation module 3-106. The one or more results may be presented in different ways in various alternative embodiments. For example, in some implementations, the presentation of the one or more results may entail the presentation module 3-108 presenting to the user 3-20* (or some other third party 3-50) an indication of a sequential relationship between a subjective user state and an objective occurrence associated with the user 3-20* (e.g., “whenever you eat a banana, you have a stomach ache). In alternative implementations, other ways of presenting the results of the correlation may be employed. For example, in various alternative implementations, a notification may be provided to notify past tendencies or patterns associated with a user 3-20*. In some implementations, a notification of a possible future outcome may be provided. In other implementations, a recommendation for a future course of action based on past patterns may be provided. These and other ways of presenting the correlation results will be described in the processes and operations to be described herein.

In various implementations, the presentation module 3-108 may include a network interface transmission module 3-252 for transmitting one or more results of the correlation performed by the correlation module 3-106 via network interface 3-120. For example, in the case where the computing device 3-10 is a server, the network interface transmission module 3-252 may be configured to transmit to the user 3-20a or a third party 3-50 the one or more results of the correlation performed by the correlation module 3-106 via a network interface 3-120.

In the same or different implementations, the presentation module 3-108 may include a user interface indication module 3-254 for indicating the one or more results of the correlation operations performed by the correlation module 3-106 via a user interface 3-122. For example, in the case where the computing device 3-10 is a local device, the user interface indication module 3-254 may be configured to indicate to a user 3-20b the one or more results of the correlation performed by the correlation module 3-106 via a user interface 3-122 (e.g., a display monitor, a touchscreen, an audio system including at least a speaker, and/or other interface devices).

The presentation module 3-108 may further include one or more sub-modules to present the one or more results of the correlation operations performed by the correlation module 3-106 in different forms. For example, in some implementations, the presentation module 3-108 may include a sequential relationship presentation module 3-256 configured to present an indication of a sequential relationship between at least one subjective user state of a user 3-20* and at least one objective occurrence. In the same or different implementations, the presentation module 3-108 may include a prediction presentation module 3-258 configured to present a prediction of a future subjective user state of a user 3-20* resulting from a future objective occurrence associated with the user 3-20*. In the same or different implementations, the prediction presentation module 3-258 may also be designed to present a prediction of a future subjective user state of a user 3-20* resulting from a past objective occurrence associated with the user 3-20*. In some implementations, the presentation module 3-108 may include a past presentation module 3-260 that is designed to present a past subjective user state of a user 3-20* in connection with a past objective occurrence associated with the user 3-20*.

In some implementations, the presentation module 3-108 may include a recommendation module 3-262 that is configured to present a recommendation for a future action based, at least in part, on the results of a correlation of subjective user state data 3-60 with objective occurrence data 3-70* performed by the correlation module 3-106. In certain implementations, the recommendation module 3-262 may further include a justification module 3-264 for presenting a justification for the recommendation presented by the recommendation module 3-262. In some implementations, the presentation module 3-108 may include a strength of correlation presentation module 3-266 for presenting an indication of a strength of correlation between subjective user state data 3-60 and objective occurrence data 3-70*.

In various embodiments, the computing device 3-10 may include a network interface 3-120 that may facilitate in communicating with a user 3-20a, one or more sensors 3-35, and/or one or more third parties 3-50. For example, in embodiments where the computing device 3-10 is a server, the computing device 3-10 may include a network interface 3-120 that may be configured to receive from the user 3-20a subjective user state data 3-60. In some embodiments, objective occurrence data 3-70a, 3-70b, and/or 3-70c may also be received through the network interface 3-120. Examples of a network interface 3-120 includes, for example, a network interface card (NIC).

The computing device 3-10, in various embodiments, may also include a memory 3-140 for storing various data. For example, in some embodiments, memory 3-140 may be employed in order to store historical data 3-72. In some implementations, the historical data 3-72 may include historical subjective user state data of a user 3-20* that may indicate one or more past subjective user states of the user 3-20* and historical objective occurrence data that may indicate one or more past objective occurrences. In same or different implementations, the historical data 3-72 may include historical medical data of a user 3-20* (e.g., genetic, metoblome, proteome information), population trends, historical sequential patterns derived from general population, and so forth.

In various embodiments, the computing device 3-10 may include a user interface 3-122 to communicate directly with a user 3-20b. For example, in embodiments in which the computing device 3-10 is a local device such as a handheld device (e.g., cellular telephone, PDA, and so forth), the user interface 3-122 may be configured to directly receive from the user 3-20b subjective user state data 3-60. The user interface 3-122 may include, for example, one or more of a display monitor, a touch screen, a key board, a key pad, a mouse, an audio system, an imaging system including a digital or video camera, and/or other user interface devices.

FIG. 3-2e illustrates particular implementations of the one or more applications 3-126 of FIG. 3-1b. For these implementations, the one or more applications 3-126 may include, for example, one or more communication applications 3-267 such as a text messaging application and/or an audio messaging application including a voice recognition system application. In some implementations, the one or more applications 3-126 may include a web 2.0 application 3-268 to facilitate communication via, for example, the World Wide Web. The functional roles of the various components, modules, and sub-modules of the computing device 3-10 presented thus far will be described in greater detail with respect to the processes and operations to be described herein. Note that the subjective user state data 3-60 may be in a variety of forms including, for example, text messages (e.g., blog entries, microblog entries, instant messages, text email messages, and so forth), audio messages, and/or images (e.g., an image capturing user's facial expression or gestures).

FIG. 3-3 illustrates an operational flow 3-300 representing example operations related to, among other things, acquisition and correlation of subjective user state data 3-60 and objective occurrence data 3-70* in accordance with various embodiments. In some embodiments, the operational flow 3-300 may be executed by, for example, the computing device 3-10 of FIG. 3-1b.

In FIG. 3-3 and in the following figures that include various examples of operational flows, discussions and explanations may be provided with respect to the above-described exemplary environment of FIGS. 3-1a and 3-1b, and/or with respect to other examples (e.g., as provided in FIGS. 3-2a to 3-20 and contexts. However, it should be understood that the operational flows may be executed in a number of other environments and contexts, and/or in modified versions of FIGS. 3-1a, 3-1b, and 3-2a to 3-2f. Also, although the various operational flows are presented in the sequence(s) illustrated, it should be understood that the various operations may be performed in other orders than those which are illustrated, or may be performed concurrently.

Further, in FIG. 3-3 and in following figures, various operations may be depicted in a box-within-a-box manner. Such depictions may indicate that an operation in an internal box may comprise an optional example embodiment of the operational step illustrated in one or more external boxes. However, it should be understood that internal box operations may be viewed as independent operations separate from any associated external boxes and may be performed in any sequence with respect to all other illustrated operations, or may be performed concurrently.

In any event, after a start operation, the operational flow 3-300 may move to a subjective user state data acquisition operation 3-302 for acquiring subjective user state data including data indicating at least one subjective user state associated with a user. For instance, the subjective user state data acquisition module 3-102 of the computing device 3-10 of FIG. 3-1b acquiring (e.g., receiving via network interface 3-120 or via user interface 3-122) subjective user state data 3-60 including data indicating at least one subjective user state 3-60a (e.g., a subjective mental state, a subjective physical state, or a subjective overall state) associated with a user 3-20*.

Operational flow 3-300 may also include an objective occurrence data solicitation operation 3-304 for soliciting, in response to the acquisition of the subjective user state data, objective occurrence data including data indicating occurrence of at least one objective occurrence. For instance, the objective occurrence data solicitation module 3-103 of the computing device 3-10 soliciting (e.g., from the user 3-20*, from one or more third parties 3-50, or from one or more sensors 3-35), in response to the acquisition of the subjective user state data 3-60, objective occurrence data 3-70* including data indicating occurrence of at least one objective occurrence 3-60a (e.g., ingestion of a food, medicine, or nutraceutical). Note that the solicitation of the objective occurrence data as described above does not necessarily mean, although it may in some cases, to solicitation of particular data that indicates occurrence of a particular or particular type of objective occurrence.

The term “soliciting” as used above may be in reference to direct or indirect solicitation of objective occurrence data 3-70* from one or more sources (e.g., user 3-20*, one or more sensors 3-35, or one or more third parties 3-50). For example, if the computing device 3-10 is a server, then the computing device 3-10 may indirectly solicit the objective occurrence data 3-70* from, for example, a user 3-20a by transmitting the solicitation (e.g., a request or inquiry) for the objective occurrence data 3-70* to the mobile device 3-30, which may then actually solicit the objective occurrence data 3-70* from the user 3-20a.

Operational flow 3-300 may further include an objective occurrence data acquisition operation 3-306 for acquiring the objective occurrence data. For instance, the objective occurrence data acquisition module 3-104 of the computing device 3-10 acquiring (e.g., receiving via user interface 3-122 or via the network interface 3-120) the objective occurrence data 3-70*.

Finally, operational flow 3-300 may include a correlation operation 3-308 for correlating the subjective user state data with the objective occurrence data. For instance, the correlation module 3-106 of the computing device 3-10 correlating the subjective user state data 3-60 with the objective occurrence data 3-70* by determining, for example, at least one sequential pattern (e.g., time sequential pattern) associated with the at least one subjective user state (e.g., user feeling “tired”) and the at least one objective occurrence (e.g., high blood sugar level).

In various implementations, the subjective user state data acquisition operation 3-302 may include one or more additional operations as illustrated in FIGS. 3-4a, 3-4b, and 3-4c. For example, in some implementations the subjective user state data acquisition operation 3-302 may include a reception operation 3-402 for receiving the subjective user state data as depicted in FIGS. 3-4a and 3-4b. For instance, the subjective user state data reception module 3-202 (see FIG. 3-2a) of the computing device 3-10 receiving (e.g., via network interface 3-120 or via the user interface 3-122) the subjective user state data 3-60.

The reception operation 3-402 may, in turn, further include one or more additional operations. For example, in some implementations, the reception operation 3-402 may include an operation 3-404 for receiving the subjective user state data via a user interface as depicted in FIG. 3-4a. For instance, the user interface data reception module 3-204 (see FIG. 3-2a) of the computing device 3-10 receiving the subjective user state data 3-60 via a user interface 3-122 (e.g., a keypad, a keyboard, a touchscreen, a mouse, an audio system including a microphone, an image capturing system including a video or digital camera, and/or other interface devices).

In some implementations, the reception operation 3-402 may include an operation 3-406 for receiving the subjective user state data via a network interface as depicted in FIG. 3-4a. For instance, the network interface data reception module 3-206 of the computing device 3-10 receiving the subjective user state data 3-60 from a wireless and/or wired network 3-40 via a network interface 3-120 (e.g., a NIC).

In various implementations, operation 3-406 may further include one or more additional operations. For example, in some implementations operation 3-406 may include an operation 3-408 for receiving data indicating the at least one subjective user state via an electronic message generated by the user as depicted in FIG. 3-4a. For instance, the network interface data reception module 3-206 of the computing device 3-10 receiving data indicating the at least one subjective user state 3-60a (e.g., subjective mental state such as feelings of happiness, sadness, anger, frustration, mental fatigue, drowsiness, alertness, and so forth) via an electronic message (e.g., email, IM, or text message) generated by the user 3-20a.

In some implementations, operation 3-406 may include an operation 3-410 for receiving data indicating the at least one subjective user state via a blog entry generated by the user as depicted in FIG. 3-4a. For instance, the network interface data reception module 3-206 of the computing device 3-10 receiving data indicating the at least one subjective user state 3-60a (e.g., subjective physical state such as physical exhaustion, physical pain such as back pain or toothache, upset stomach, blurry vision, and so forth) via a blog entry such as a microblog entry generated by the user 3-20a.

In some implementations, operation 3-406 may include an operation 3-412 for receiving data indicating the at least one subjective user state via a status report generated by the user as depicted in FIG. 3-4a. For instance, the network interface data reception module 3-206 of the computing device 3-10 receiving data indicating the at least one subjective user state 3-60a (e.g., subjective overall state of the user 3-20* such as good, bad, well, exhausted, and so forth) via a status report (e.g., social network site status report) generated by the user 3-20a.

In some implementations, the reception operation 3-402 may include an operation 3-414 for receiving subjective user state data including data indicating at least one subjective user state specified by a selection made by the user, the selection being a selection of a subjective user state from a plurality of indicated alternative subjective user states as depicted in FIG. 3-4a. For instance, the subjective user state data reception module 3-202 of the computing device 3-10 receiving subjective user state data 3-60 including data indicating at least one subjective user state 3-60a specified by a selection (e.g., via mobile device 3-30 or via user interface 3-122) made by the user 3-20*, the selection being a selection of a subjective user state from a plurality of indicated alternative subjective user states (e.g., as provided by the mobile device 3-30 or by the user interface 3-122). For example, the user 3-20* may be given the option of selecting one or more subjective user states from a list of identified subjective user states that are shown or indicated by the mobile device 3-30 or by the user interface 3-122.

Operation 3-414 may include one or more additional operations in various alternative implementations. For example, in some implementations, operation 3-414 may include an operation 3-416 for receiving subjective user state data including data indicating at least one subjective user state specified by a selection made by the user, the selection being a selection of a subjective user state from at least two indicated alternative contrasting subjective user states as depicted in FIG. 3-4a. For instance, the subjective user state data reception module 3-202 of the computing device 3-10 receiving subjective user state data 3-60 including data indicating at least one subjective user state 3-60a specified (e.g., via the mobile device 3-30 or via the user interface 3-122) by a selection made by the user 3-20*, the selection being a selection of a subjective user state from at least two indicated alternative contrasting subjective user states (e.g., is user in pain or not in pain?, or alternatively, is user in extreme pain, user in moderate pain, or user not in pain?).

In some implementations, operation 3-414 may include an operation 3-417 for receiving the selection via a network interface as depicted in FIG. 3-4a. For instance, the network interface data reception module 3-206 of the computing device 3-10 receiving the selection of a subjective user state (e.g., a subjective mental state, a subjective physical state, or a subjective overall state) via a network interface 3-120.

In some implementations, operation 3-414 may include an operation 3-418 for receiving the selection via user interface as depicted in FIG. 3-4a. For instance, the user interface data reception module 3-204 of the computing device 3-10 receiving the selection of a subjective user state (e.g., a subjective mental state, a subjective physical state, or a subjective overall state) via a user interface 3-122.

In some implementations, the reception operation 3-402 may include an operation 3-420 for receiving data indicating at least one subjective user state associated with the user that was obtained based, at least in part, on a text entry provided by the user as depicted in FIG. 3-4b. For instance, the subjective user state data reception module 3-202 of the computing device 3-10 receiving data indicating at least one subjective user state 3-60a (e.g., a subjective mental state, a subjective physical state, or a subjective overall state) associated with the user 3-20* that was obtained based, at least in part, on a text entry provided by the user 3-20* (e.g., text data provided by the user 3-20* via the mobile device 3-30 or via the user interface 3-122).

In some implementations, the reception operation 3-402 may include an operation 3-422 for receiving data indicating at least one subjective user state associated with the user that was obtained based, at least in part, on an audio entry provided by the user as depicted in FIG. 3-4b. For instance, the subjective user state data reception module 3-202 of the computing device 3-10 receiving data indicating at least one subjective user state 3-60a (e.g., a subjective mental state, a subjective physical state, or a subjective overall state) associated with the user 3-20* that was obtained based, at least in part, on an audio entry provided by the user 3-20* (e.g., audio recording made via the mobile device 3-30 or via the user interface 3-122).

In some implementations, the reception operation 3-402 may include an operation 3-424 for receiving data indicating at least one subjective user state associated with the user that was obtained based, at least in part, on an image entry provided by the user as depicted in FIG. 3-4b. For instance, the subjective user state data reception module 3-202 of the computing device 3-10 receiving data indicating at least one subjective user state 3-60a (e.g., a subjective mental state, a subjective physical state, or a subjective overall state) associated with the user 3-20* that was obtained based, at least in part, on an image entry provided by the user 3-20* (e.g., one or more images recorded via the mobile device 3-30 or via the user interface 3-122).

Operation 3-424 may further include one or more additional operations in various alternative implementations. For example, in some implementations, operation 3-424 may include an operation 3-426 for receiving data indicating at least one subjective user state associated with the user that was obtained based, at least in part, on an image entry showing a gesture made by the user as depicted in FIG. 3-4b. For instance, the subjective user state data reception module 3-202 of the computing device 3-10 receiving data indicating at least one subjective user state 3-60a (e.g., a subjective user state such as “user is good” or “user is not good”) associated with the user 3-20* that was obtained based, at least in part, on an image entry showing a gesture (e.g., a thumb up or a thumb down) made by the user 3-20*.

In some implementations, operation 3-424 may include an operation 3-428 for receiving data indicating at least one subjective user state associated with the user that was obtained based, at least in part, on an image entry showing an expression made by the user as depicted in FIG. 3-4b. For instance, the subjective user state data reception module 3-202 of the computing device 3-10 receiving data indicating at least one subjective user state 3-60a (e.g., a subjective mental state such as happiness or sadness) associated with the user 3-20* that was obtained based, at least in part, on an image entry showing an expression (e.g., a smile or a frown expression) made by the user 3-20*.

In some implementations, the reception operation 3-402 may include an operation 3-430 for receiving data indicating at least one subjective user state associated with the user that was obtained based, at least in part, on data provided through user interaction with a user interface as depicted in FIG. 3-4b. For instance, the subjective user state data reception module 3-202 of the computing device 3-10 receiving data indicating at least one subjective user state 3-60a associated with the user 3-20* that was obtained based, at least in part, on data provided through user interaction (e.g., user 3-20* selecting one subjective user state from a plurality of alternative subjective user states) with a user interface 3-122 (e.g., keypad, a touchscreen, a microphone, and so forth) of the computing device 3-10 or with a user interface of the mobile device 3-30.

In various implementations, the subjective user state data acquisition operation 3-302 may include an operation 3-432 for acquiring data indicating at least one subjective mental state of the user as depicted in FIG. 3-4b. For instance, the subjective user state data acquisition module 3-102 of the computing device 3-10 acquiring (e.g., via network interface 3-120 or via user interface 3-122) data indicating at least one subjective mental state (e.g., sadness, happiness, alertness or lack of alertness, anger, frustration, envy, hatred, disgust, and so forth) of the user 3-20*.

In some implementations, operation 3-432 may further include an operation 3-434 for acquiring data indicating at least a level of the one subjective mental state of the user as depicted in FIG. 3-4b. For instance, the subjective user state data acquisition module 3-102 of the computing device 3-10 acquiring data indicating at least a level of the one subjective mental state (e.g., extreme sadness or slight sadness) of the user 3-20*.

In various implementations, the subjective user state data acquisition operation 3-302 may include an operation 3-436 for acquiring data indicating at least one subjective physical state of the user as depicted in FIG. 3-4b. For instance, the subjective user state data acquisition module 3-102 of the computing device 3-10 acquiring (e.g., via network interface 3-120 or via user interface 3-122) data indicating at least one subjective physical state (e.g., blurry vision, physical pain such as backache or headache, upset stomach, physical exhaustion, and so forth) of the user 3-20*.

In some implementations, operation 3-436 may further include an operation 3-438 for acquiring data indicating at least a level of the one subjective physical state of the user as depicted in FIG. 3-4b. For instance, the subjective user state data acquisition module 3-102 of the computing device 3-10 acquiring data indicating at least a level of the one subjective physical state (e.g., a slight headache or a severe headache) of the user 3-20*.

In various implementations, the subjective user state data acquisition operation 3-302 may include an operation 3-440 for acquiring data indicating at least one subjective overall state of the user as depicted in FIG. 3-4c. For instance, the subjective user state data acquisition module 3-102 of the computing device 3-10 acquiring (e.g., via network interface 3-120 or via user interface 3-122) data indicating at least one subjective overall state (e.g., good, bad, wellness, hangover, fatigue, nausea, and so forth) of the user 3-20*. Note that a subjective overall state, as used herein, may be in reference to any subjective user state that may not fit neatly into the categories of subjective mental state or subjective physical state.

In some implementations, operation 3-440 may further include an operation 3-442 for acquiring data indicating at least a level of the one subjective overall state of the user as depicted in FIG. 3-4c. For instance, the subjective user state data acquisition module 3-102 of the computing device 3-10 acquiring data indicating at least a level of the one subjective overall state (e.g., a very bad hangover) of the user 3-20*.

In some implementations the subjective user state data acquisition operation 3-302 may include an operation 3-444 for acquiring a time stamp associated with occurrence of the at least one subjective user state as depicted in FIG. 3-4c. For instance, the time stamp acquisition module 3-210 (see FIG. 3-2a) of the computing device 3-10 acquiring (e.g., receiving via the network interface 3-120 or via the user interface 3-122 as provided by the user 3-20* or by automatically or self generating) a time stamp (e.g., 10 PM Aug. 4, 2009) associated with occurrence of the at least one subjective user state.

In some implementations the subjective user state data acquisition operation 3-302 may include an operation 3-446 for acquiring an indication of a time interval associated with occurrence of the at least one subjective user state as depicted in FIG. 3-4c. For instance, the time interval acquisition module 3-212 of the computing device 3-10 acquiring (e.g., via the network interface 3-120 or via the user interface 3-122 as provided by the user 3-20* or by automatically generating) an indication of a time interval (e.g., 8 AM to 10 AM Jul. 24, 2009) associated with occurrence of the at least one subjective user state.

In some implementations the subjective user state data acquisition operation 3-302 may include an operation 3-448 for acquiring an indication of a temporal relationship between occurrence of the at least one subjective user state and occurrence of the at least one objective occurrence as depicted in FIG. 3-4c. For instance, the temporal relationship acquisition module 3-214 of the computing device 3-10 acquiring (e.g., via the network interface 3-120 or via the user interface 3-122 as provided by the user 3-20* or by automatically generating) an indication of a temporal relationship (e.g., before, after, or at least partially concurrently) between occurrence of the at least one subjective user state (e.g., easing of a headache) and occurrence of at least one objective occurrence (e.g., ingestion of aspirin). For example, acquiring an indication that a user's headache eased after taking an aspirin.

In some implementations the subjective user state data acquisition operation 3-302 may include an operation 3-450 for acquiring the subjective user state data at a server as depicted in FIG. 3-4c. For instance, when the computing device 3-10 is a network server and is acquiring the subjective user state data 3-60.

In some implementations the subjective user state data acquisition operation 3-302 may include an operation 3-452 for acquiring the subjective user state data at a handheld device as depicted in FIG. 3-4c. For instance, when the computing device 3-10 is a handheld device such as a mobile phone or a PDA and is acquiring the subjective user state data 3-60.

In some implementations the subjective user state data acquisition operation 3-302 may include an operation 3-454 for acquiring the subjective user state data at a peer-to-peer network component device as depicted in FIG. 3-4c. For instance, when the computing device 3-10 is a peer-to-peer network component device and is acquiring the subjective user state data 3-60.

In some implementations the subjective user state data acquisition operation 3-302 may include an operation 3-456 for acquiring the subjective user state data via a Web 2.0 construct as depicted in FIG. 3-4c. For instance, when the computing device 3-10 employs a Web 2.0 application in order to acquire the subjective user state data 3-60.

Referring back to FIG. 3-3, the objective occurrence data solicitation operation 3-304 in various embodiments may include one or more additional operations as illustrated in FIGS. 3-5a to 3-5d. For example, in some implementations, the objective occurrence data solicitation operation 3-304 may include an operation 3-500 for soliciting from the user the data indicating occurrence of at least one objective occurrence as depicted in FIGS. 3-5a and 3-5b. For instance, the objective occurrence data solicitation module 3-103 of the computing device 3-10 soliciting (e.g., via network interface 3-120 or via user interface 3-122) from the user 3-20* the data indicating occurrence of at least one objective occurrence (e.g., ingestion of a food item, medicine, or nutraceutical, exercise or other activities performed by the user 3-20* or by others, or external events such as weather or performance of the stock market).

Operation 3-500 may also further include one or more additional operations. For example, in some implementations, operation 3-500 may include an operation 3-502 for soliciting the data indicating an occurrence of at least one objective occurrence via user interface as depicted in FIG. 3-5a. For instance, the user interface solicitation module 3-216 of the computing device 3-10 soliciting (e.g., requesting or seeking from the user 3-20b) the data indicating an occurrence of at least one objective occurrence (e.g., ingestion of a food item, a medicine, or a nutraceutical by the user 3-20b) via user interface 3-122.

Operation 3-502, in turn, may include one or more additional operations. For example, in some implementations, operation 3-502 may include an operation 3-504 for soliciting the data indicating an occurrence of at least one objective occurrence through at least one of a display monitor or a touchscreen as depicted in FIG. 3-5a. For instance, the user interface solicitation module 3-216 of the computing device 3-10 soliciting (e.g., requesting or seeking from the user 3-20b) the data indicating an occurrence of at least one objective occurrence (e.g., social, work, or exercise activity performed by the user 3-20b or by a third party 3-50) through at least one of a display monitor or a touchscreen.

In some implementations, operation 3-502 may include an operation 3-506 for soliciting the data indicating an occurrence of at least one objective occurrence through at least an audio system as depicted in FIG. 3-5a. For instance, the user interface solicitation module 3-216 of the computing device 3-10 soliciting the data indicating an occurrence of at least one objective occurrence (e.g., activity performed by a third party 3-50 or a physical characteristic of the user 3-20b such as blood pressure) through at least an audio system (e.g., a speaker system).

In various implementations, operation 3-500 may include an operation 3-508 for soliciting the data indicating an occurrence of at least one objective occurrence via a network interface as depicted in FIG. 3-5a. For instance, the network interface solicitation module 3-215 (see FIG. 3-2b) soliciting (e.g., requesting or seeking from the user 3-20a, one or more third parties 3-50, or from one or more sensors 3-35) the data indicating an occurrence of at least one objective occurrence (e.g., an external event such as local weather or the location of the user 3-20*) via a network interface 3-120.

In some implementations, operation 3-500 may include an operation 3-510 for requesting the user to confirm occurrence of at least one objective occurrence as depicted in FIG. 3-5a. For instance, the requesting module 3-217 (see FIG. 3-2b) of the computing device 3-10 requesting (e.g., transmitting a request or an inquiry via the network interface 3-120 or displaying a request or an inquiry via the user interface 3-122) the user 3-20* to confirm occurrence of at least one objective occurrence (e.g., did user 3-20* ingest a particular type of medicine?).

In some implementations, operation 3-500 may include an operation 3-512 for requesting the user to select at least one objective occurrence from a plurality of indicated alternative objective occurrences as depicted in FIG. 3-5a. For instance, the requesting module 3-217 of the computing device 3-10 requesting (e.g., transmitting a request via the network interface 3-120 or displaying a request via the user interface 3-122) the user 3-20* to select at least one objective occurrence from a plurality of indicated alternative objective occurrences (e.g., did user ingest aspirin, ibuprofen, or acetaminophen today?). For example, the user 3-20* may be given the option of selecting one or more objective occurrences from a list of identified objective occurrences that are shown or indicated by the mobile device 3-30 or by the user interface 3-122.

Operation 3-512, in various implementations, may in turn include an operation 3-514 for requesting the user to select one objective occurrence from at least two indicated alternative contrasting objective occurrences as depicted in FIG. 3-5a. For instance, the requesting module 3-217 of the computing device 3-10 requesting (e.g., transmitting a request via the network interface 3-120 or displaying a request via the user interface 3-122) the user 3-20* to select one objective occurrence from at least two indicated alternative contrasting objective occurrences (e.g., ambient temperature being greater than or equal to 90 degrees or less than 90 degrees?).

In some implementations, operation 3-500 may include an operation 3-516 for requesting the user to provide an indication of occurrence of at least one objective occurrence with respect to occurrence of the at least one subjective user state as depicted in FIG. 3-5a. For instance, the requesting module 3-217 of the computing device 3-10 requesting (e.g., via the network interface 3-120 or via the user interface 3-122) the user 3-20* to provide an indication of occurrence of at least one objective occurrence with respect to occurrence of the at least one subjective user state (you felt sick this morning, did you drink last night?).

In some implementations, operation 3-500 may include an operation 3-518 for requesting the user to provide an indication of occurrence of at least one objective occurrence associated with a particular type of objective occurrences as depicted in FIG. 3-5b. For instance, the requesting module 3-217 of the computing device 3-10 requesting (e.g., via the network interface 3-120 or via the user interface 3-122) the user 3-20* to provide an indication of occurrence of at least one objective occurrence associated with a particular type of objective occurrences (e.g., what type of exercise did you do today?).

In some implementations, operation 3-500 may include an operation 3-520 for requesting the user to provide an indication of a time or temporal element associated with occurrence of the at least one objective occurrence as depicted in FIG. 3-5b. For instance, the requesting module 3-217 of the computing device 3-10 requesting (e.g., via the network interface 3-120 or via the user interface 3-122) the user 3-20* to provide an indication of a time or temporal element associated with occurrence of the at least one objective occurrence (e.g., what time did you exercise or did you exercise before or after eating lunch?).

Operation 3-520 in various implementations may further include one or more additional operations. For example, in some implementations, operation 3-520 may include an operation 3-522 for requesting the user to provide an indication of a point in time associated with the occurrence of the at least one objective occurrence as depicted in FIG. 3-5b. For instance, the requesting module 3-217 of the computing device 3-10 requesting (e.g., via the network interface 3-120 or via the user interface 3-122) the user 3-20* to provide an indication of a point in time associated with the occurrence of the at least one objective occurrence (e.g., at what time of the day did you ingest the aspirin?).

In some implementations, operation 3-520 may include an operation 3-524 for requesting the user to provide an indication of a time interval associated with the occurrence of the at least one objective occurrence as depicted in FIG. 3-5b. For instance, the requesting module 3-217 of the computing device 3-10 requesting (e.g., via the network interface 3-120 or via the user interface 3-122) the user 3-20* to provide an indication of a time interval associated with the occurrence of the at least one objective occurrence (e.g., from what time to what time did you take your walk?).

In some implementations, operation 3-500 may include an operation 3-526 for requesting the user to provide an indication of temporal relationship between occurrence of the at least one objective occurrence and occurrence of the at least one subjective user state as depicted in FIG. 3-5b. For instance, the requesting module 3-217 of the computing device 3-10 requesting (e.g., via the network interface 3-120 or via the user interface 3-122) the user 3-20* to provide an indication of temporal relationship between occurrence of the at least one objective occurrence and occurrence of the at least one subjective user state (e.g., did you ingest the ibuprofen before or after your headache went away?).

In various implementations, the solicitation operation 3-304 of FIG. 3-3 may include an operation 3-528 for soliciting from one or more third party sources the data indicating occurrence of at least one objective occurrence as depicted in FIG. 3-5c. For instance, the objective occurrence data solicitation module 3-103 of the computing device 3-10 soliciting from one or more third party sources (e.g., a fitness gym, a healthcare facility, another user, a content provider, or other third party source) the data indicating occurrence of at least one objective occurrence (e.g., weather, medical treatment, user 3-20* or third party activity, and so forth).

Operation 3-528 may, in turn, include one or more additional operations in various alternative implementations. For example, in some implementations, operation 3-528 may include an operation 3-530 for requesting from one or more other users the data indicating occurrence of at least one objective occurrence as depicted in FIG. 3-5c. For instance, the requesting module 3-217 of the computing device 3-10 requesting (e.g., via wireless and/or wired network 3-40) from one or more other users (e.g., other microbloggers) the data indicating occurrence of at least one objective occurrence (e.g., user activities observed by the one or more other users or the one or more other users' activities).

In some implementations, operation 3-528 may include an operation 3-532 for requesting from one or more healthcare entities the data indicating occurrence of at least one objective occurrence as depicted in FIG. 3-5c. For instance, the requesting module 3-217 of the computing device 3-10 requesting (e.g., via an electronic message) from one or more healthcare entities (e.g., physician's or dental office, medical clinic, hospital, and so forth) the data indicating occurrence of at least one objective occurrence (e.g., occurrence of a medical or dental treatment).

In some implementations, operation 3-528 may include an operation 3-533 for requesting from one or more content providers the data indicating occurrence of at least one objective occurrence as depicted in FIG. 3-5c. For instance, the requesting module 3-217 of the computing device 3-10 requesting (e.g., via a network interface 3-120) from one or more content providers the data indicating occurrence of at least one objective occurrence (e.g., weather or stock market performance).

In some implementations, operation 3-528 may include an operation 3-534 for requesting from one or more third party sources the data indicating occurrence of at least one objective occurrence that occurred at a specified point in time as depicted in FIG. 3-5c. For instance, the requesting module 3-217 of the computing device 3-10 requesting (e.g., via a network interface 3-120) from one or more third party sources (e.g., dental office) the data indicating occurrence of at least one objective occurrence that occurred at a specified point in time (e.g., asking whether the user 3-20* was sedated with nitrous oxide at 3 PM during a dental procedure).

In some implementations, operation 3-528 may include an operation 3-535 for requesting from one or more third party sources the data indicating occurrence of at least one objective occurrence that occurred during a specified time interval as depicted in FIG. 3-5c. For instance, the requesting module 3-217 of the computing device 3-10 requesting (e.g., via a network interface 3-120) from one or more third party sources (e.g., fitness instructor or gym) the data indicating occurrence of at least one objective occurrence that occurred during a specified time interval (e.g., did user exercise on the treadmill between 6 AM and 12 PM?).

In some implementations, the solicitation operation 3-304 of FIG. 3-3 may include an operation 3-536 for soliciting from one or more sensors the data indicating occurrence of at least one objective occurrence as depicted in FIG. 3-5c. For instance, the objective occurrence data solicitation module 3-103 of the computing device 3-10 soliciting (e.g., via a network interface 3-120) from one or more sensors 3-35 (e.g., GPS) the data indicating occurrence of at least one objective occurrence (e.g., user location).

Operation 3-536 may include, in various implementations, one or more additional operations. For example, in some implementations, operation 3-536 may include an operation 3-538 for configuring the one or more sensors to collect and provide the data indicating occurrence of at least one objective occurrence as depicted in FIG. 3-5c. For instance, the configuration module 3-218 of the computing device 3-10 configuring the one or more sensors 3-35 (e.g., blood pressure device, glucometer, GPS, pedometer, or other sensors 3-35) to collect and provide the data indicating occurrence of at least one objective occurrence.

In some implementations, operation 3-536 may include an operation 3-540 for directing or instructing the one or more sensors to collect and provide the data indicating occurrence of at least one objective occurrence as depicted in FIG. 3-5c. For instance, the directing/instructing module 3-219 of the computing device directing or instructing the one or more sensors 3-35 (e.g., blood pressure device, glucometer, GPS, pedometer, or other sensors 3-35) to collect and provide the data indicating occurrence of at least one objective occurrence

The solicitation operation 3-304 of FIG. 3-3, in various implementations, may include an operation 3-542 for soliciting the data indicating occurrence of at least one objective occurrence in response to the acquisition of the subjective user state data and based on historical data as depicted in FIG. 3-5d. For instance, the objective occurrence data solicitation module 3-103 of the computing device 3-10 being prompted to soliciting the data indicating occurrence of at least one objective occurrence (e.g., asking whether the user 3-20* ate anything or ate a chocolate sundae) in response to the acquisition of the subjective user state data 3-60 (e.g., subjective user state data 3-60 indicating a stomach ache) and based on historical data 3-72 (e.g., a previously determined sequential pattern associated with the user 3-20* indicating that the user 3-20* may have gotten a stomach ache after eating a chocolate sundae).

In various implementations, operation 3-542 may further include one or more additional operations. For example, in some implementations, operation 3-542 may include an operation 3-544 for soliciting the data indicating occurrence of at least one objective occurrence based, at least in part, on one or more historical sequential patterns as depicted in FIG. 3-5d. For instance, the objective occurrence data solicitation module 3-103 of the computing device 3-10 soliciting (e.g., via network interface 3-120 or via user interface 3-122) the data indicating occurrence of at least one objective occurrence based, at least in part, on referencing of one or more historical sequential patterns (e.g., historical sequential patterns derived from general population or from a group of users 3-20*).

In some implementations, operation 3-542 may include an operation 3-546 for soliciting the data indicating occurrence of at least one objective occurrence based, at least in part, on medical data of the user as depicted in FIG. 3-5d. For instance, the objective occurrence data solicitation module 3-103 of the computing device 3-10 soliciting (e.g., via network interface 3-120 or via user interface 3-122) the data indicating occurrence of at least one objective occurrence based, at least in part, on medical data of the user 3-20* (e.g., genetic, metabolome, or proteome data of the user).

In some implementations, operation 3-542 may include an operation 3-547 for soliciting the data indicating occurrence of at least one objective occurrence based, at least in part, on historical data indicative of a link between a subjective user state type and an objective occurrence type as depicted in FIG. 3-5d. For instance, the objective occurrence data solicitation module 3-103 of the computing device 3-10 soliciting (e.g., via network interface 3-120 or via user interface 3-122) the data indicating occurrence of at least one objective occurrence (e.g., local weather) based, at least in part, on historical data 3-72 indicative of a link between a subjective user state type and an objective occurrence type (e.g., link between moods of people and weather).

In some implementations, operation 3-542 may include an operation 3-548 for soliciting the data indicating occurrence of at least one objective occurrence, the soliciting prompted, at least in part, by the historical data as depicted in FIG. 3-5d. For instance, the objective occurrence data solicitation module 3-103 of the computing device 3-10 soliciting (e.g., via network interface 3-120 or via user interface 3-122) the data indicating occurrence of at least one objective occurrence (e.g., weather), the soliciting prompted, at least in part, by the historical data 3-72 (e.g., historical data 3-72 that indicates that the user 3-20* or people in the general population tend to be gloomy (a subjective user state) when the weather is overcast).

In some implementations, operation 3-542 may include an operation 3-549 for soliciting data indicating occurrence of a particular or a particular type of objective occurrence based on the historical data as depicted in FIG. 3-5d. For instance, the objective occurrence data solicitation module 3-103 of the computing device 3-10 soliciting (e.g., via network interface 3-120 or via user interface 3-122) data indicating occurrence of a particular or a particular type of objective occurrence (e.g., requesting performance of shares of particular stock) based on the historical data 3-72 (e.g., historical data 3-72 that indicates that the user 3-20* is happy when the shares of particular stocks rise).

In some implementations, the solicitation operation 3-304 of FIG. 3-3 may include an operation 3-550 for soliciting data indicating one or more attributes associated with occurrence of the at least one objective occurrence as depicted in FIG. 3-5d. For instance, the objective occurrence data solicitation module 3-103 of the computing device 3-10 soliciting (e.g., via network interface 3-120 or via user interface 3-122) data indicating one or more attributes associated with occurrence of the at least one objective occurrence (e.g., how hard or how long did it rain on Tuesday?).

In some implementations, the solicitation operation 3-304 may include an operation 3-551 for soliciting the data indicating occurrence of at least one objective occurrence by requesting access to the data indicating occurrence of the at least one objective occurrence as depicted in FIG. 3-5d. For instance, the objective occurrence data solicitation module 3-103 of the computing device 3-10 soliciting (e.g., via network interface 3-120) the data indicating occurrence of at least one objective occurrence by requesting access to the data indicating occurrence of the at least one objective occurrence (e.g., by requesting access to the file containing the data or to the location of the data or to the data itself).

In various embodiments, the objective occurrence data acquisition operation 3-306 of FIG. 3-3 may include one or more additional operations as illustrated in FIGS. 3-6a to 3-6c. For example, in some implementations, the objective occurrence data acquisition operation 3-306 may include an operation 3-602 for receiving the objective occurrence data via a user interface as depicted in FIG. 3-6a. For instance, the objective occurrence data user interface reception module 3-226 (see FIG. 3-2c) of the computing device 3-10 receiving the objective occurrence data 3-70* via a user interface 3-122 (e.g., a key pad, a touchscreen, an audio system including a microphone, an image capturing system such as a digital or video camera, or other user interfaces 3-122).

In some implementations, the objective occurrence data acquisition operation 3-306 may include an operation 3-604 for receiving the objective occurrence data from at least one of a wireless network or a wired network as depicted in FIG. 3-6a. For instance, the objective occurrence data network interface reception module 3-227 of the computing device 3-10 receiving (e.g., via the network interface 3-120) the objective occurrence data 3-70* from at least one of a wireless and/or a wired network 3-40.

In some implementations, the objective occurrence data acquisition operation 3-306 may include an operation 3-606 for receiving the objective occurrence data via one or more blog entries as depicted in FIG. 3-6a. For instance, the reception module 3-224 of the computing device 3-10 receiving (e.g., via network interface 3-120) the objective occurrence data 3-70a or 3-70c via one or more blog entries (e.g., microblog entries).

In some implementations, the objective occurrence data acquisition operation 3-306 may include an operation 3-608 for receiving the objective occurrence data via one or more status reports as depicted in FIG. 3-6a. For instance, the reception module 3-224 of the computing device 3-10 receiving (e.g., via network interface 3-120) the objective occurrence data 3-70* via one or more status reports (e.g., as generated by the user 3-20* or by one or more third parties 3-50).

In some implementations, the objective occurrence data acquisition operation 3-306 may include an operation 3-610 for receiving the objective occurrence data from the user as depicted in FIG. 3-6a. For instance, the reception module 3-224 of the computing device 3-10 receiving (e.g., via network interface 3-120 or via the user interface 3-122) the objective occurrence data 3-70* from the user 3-20*.

In some implementations, the objective occurrence data acquisition operation 3-306 may include an operation 3-612 for receiving the objective occurrence data from one or more third party sources as depicted in FIG. 3-6a. For instance, the reception module 3-224 of the computing device 3-10 receiving (e.g., via network interface 3-120) the objective occurrence data 3-70* from one or more third party sources (e.g., other users 3-20*, healthcare entities, content providers, or other third party sources).

In some implementations, the objective occurrence data acquisition operation 3-306 may include an operation 3-614 for receiving the objective occurrence data from one or more sensors configured to sense one or more objective occurrences as depicted in FIG. 3-6a. For instance, the reception module 3-224 of the computing device 3-10 receiving (e.g., via network interface 3-120) the objective occurrence data 3-70* from one or more sensors 3-35 (e.g., a physiological sensing device, a physical activity sensing device such as a pedometer, a GPS, and so forth) configured to sense one or more objective occurrences.

In some implementations, the objective occurrence data acquisition operation 3-306 may include an operation 3-616 for acquiring at least one time stamp associated with occurrence of at least one objective occurrence as depicted in FIG. 3-6b. For instance, the time stamp acquisition module 3-230 (see FIG. 3-2c) of the computing device 3-10 acquiring (e.g., via the network interface 3-120, via the user interface 3-122 as provided by the user 3-20*, or by automatically generating) at least one time stamp associated with occurrence of at least one objective occurrence.

In some implementations, the objective occurrence data acquisition operation 3-306 may include an operation 3-618 for acquiring an indication of at least one time interval associated with occurrence of at least one objective occurrence as depicted in FIG. 3-6b. For instance, the time interval acquisition module 3-231 of the computing device 3-10 acquiring (e.g., via the network interface 3-120, via the user interface 3-122 as provided by the user 3-20*, or by automatically generating) an indication of at least one time interval associated with occurrence of at least one objective occurrence.

In some implementations, the objective occurrence data acquisition operation 3-306 may include an operation 3-619 for acquiring an indication of at least a temporal relationship between the at least one objective occurrence and occurrence of the at least one subjective user state as depicted in FIG. 3-6b. For instance, the temporal relationship acquisition module 3-232 of the computing device 3-10 acquiring (e.g., via the network interface 3-120, via the user interface 3-122 as provided by the user 3-20*, or by automatically generating) an indication of at least a temporal relationship (e.g., before, after, or at least partially concurrently) between the at least one objective occurrence and occurrence of the at least one subjective user state.

In some implementations, the objective occurrence data acquisition operation 3-306 may include an operation 3-620 for acquiring data indicating at least one objective occurrence and one or more attributes associated with the at least one objective occurrence as depicted in FIG. 3-6b. For instance, the objective occurrence data acquisition module 3-104 of the computing device 3-10 acquiring data indicating at least one objective occurrence (e.g., ingestion of a medicine or food item) and one or more attributes (e.g., quality, quantity, brand, and/or source of the medicine or food item ingested) associated with the at least one objective occurrence.

In some implementations, the objective occurrence data acquisition operation 3-306 may include an operation 3-622 for acquiring data indicating at least one objective occurrence of an ingestion by the user of a medicine as depicted in FIG. 3-6b. For instance, the objective occurrence data acquisition module 3-104 of the computing device 3-10 acquiring (e.g., via the network interface 3-120 or via the user interface 3-122) data indicating at least one objective occurrence of an ingestion by the user 3-20* of a medicine (e.g., a dosage of a beta blocker).

In some implementations, the objective occurrence data acquisition operation 3-306 may include an operation 3-624 for acquiring data indicating at least one objective occurrence of an ingestion by the user of a food item as depicted in FIG. 3-6b. For instance, the objective occurrence data acquisition module 3-104 of the computing device 3-10 acquiring (e.g., via the network interface 3-120 or via the user interface 3-122) data indicating at least one objective occurrence of an ingestion by the user 3-20* of a food item (e.g., an orange).

In some implementations, the objective occurrence data acquisition operation 3-306 may include an operation 3-626 for acquiring data indicating at least one objective occurrence of an ingestion by the user of a nutraceutical as depicted in FIG. 3-6b. For instance, the objective occurrence data acquisition module 3-104 of the computing device 3-10 acquiring (e.g., via the network interface 3-120 or via the user interface 3-122) data indicating at least one objective occurrence of an ingestion by the user 3-20* of a nutraceutical (e.g. broccoli).

In some implementations, the objective occurrence data acquisition operation 3-306 may include an operation 3-628 for acquiring data indicating at least one objective occurrence of an exercise routine executed by the user as depicted in FIG. 3-6b. For instance, the objective occurrence data acquisition module 3-104 of the computing device 3-10 acquiring (e.g., via the network interface 3-120 or via the user interface 3-122) data indicating at least one objective occurrence of an exercise routine (e.g., working out on an exercise machine such as a treadmill) executed by the user 3-20*.

In some implementations, the objective occurrence data acquisition operation 3-306 may include an operation 3-630 for acquiring data indicating at least one objective occurrence of a social activity executed by the user as depicted in FIG. 3-6c. For instance, the objective occurrence data acquisition module 3-104 of the computing device 3-10 acquiring (e.g., via the network interface 3-120 or via the user interface 3-122) data indicating at least one objective occurrence of a social activity (e.g., hiking with friends) executed by the user 3-20*.

In some implementations, the objective occurrence data acquisition operation 3-306 may include an operation 3-632 for acquiring data indicating at least one objective occurrence of an activity performed by a third party as depicted in FIG. 3-6c. For instance, the objective occurrence data acquisition module 3-104 of the computing device 3-10 acquiring (e.g., via the network interface 3-120 or via the user interface 3-122) data indicating at least one objective occurrence of an activity (e.g., boss on a vacation) performed by a third party 3-50.

In some implementations, the objective occurrence data acquisition operation 3-306 may include an operation 3-634 for acquiring data indicating at least one objective occurrence of a physical characteristic of the user as depicted in FIG. 3-6c. For instance, the objective occurrence data acquisition module 3-104 of the computing device 3-10 acquiring (e.g., via the network interface 3-120 or via the user interface 3-122) data indicating at least one objective occurrence of a physical characteristic (e.g., a blood sugar level) of the user 3-20*. Note that a physical characteristic such as a blood sugar level could be determined using a device such as a glucometer and then reported by the user 3-20*, by a third party 3-50, or by the device (e.g., glucometer) itself.

In some implementations, the objective occurrence data acquisition operation 3-306 may include an operation 3-636 for acquiring data indicating at least one objective occurrence of a resting, a learning or a recreational activity by the user as depicted in FIG. 3-6c. For instance, the objective occurrence data acquisition module 3-104 of the computing device 3-10 acquiring (e.g., via the network interface 3-120 or via the user interface 3-122) data indicating at least one objective occurrence of a resting (e.g., sleeping), a learning (e.g., reading), or a recreational activity (e.g., a round of golf) by the user 3-20*.

In some implementations, the objective occurrence data acquisition operation 3-306 may include an operation 3-638 for acquiring data indicating at least one objective occurrence of an external event as depicted in FIG. 3-6c. For instance, the objective occurrence data acquisition module 3-104 of the computing device 3-10 acquiring (e.g., via the network interface 3-120 or via the user interface 3-122) data indicating at least one objective occurrence of an external event (e.g., rain storm).

In some implementations, the objective occurrence data acquisition operation 3-306 may include an operation 3-640 for acquiring data indicating at least one objective occurrence related to a location of the user as depicted in FIG. 3-6c. For instance, the objective occurrence data acquisition module 3-104 of the computing device 3-10 acquiring (e.g., via the network interface 3-120 or via the user interface 3-122) data indicating at least one objective occurrence related to a location (e.g., work office at a first point or interval in time) of the user 3-20*. In some instances, such data may be provided by the user 3-20* via the user interface 3-122 (e.g., in the case where the computing device 3-10 is a local device) or via the mobile device 3-30 (e.g., in the case where the computing device 3-10 is a network server). Alternatively, such data may be provided directly by a sensor device 3-35 such as a GPS device, or by a third party 3-50.

Referring back to FIG. 3-3, the correlation operation 3-308 may include one or more additional operations in various alternative implementations. For example, in various implementations, the correlation operation 3-308 may include an operation 3-702 for correlating the subjective user state data with the objective occurrence data based, at least in part, on a determination of at least one sequential pattern associated with the at least one subjective user state and the at least one objective occurrence as depicted in FIG. 3-7a. For instance, the correlation module 3-106 of the computing device 3-10 correlating the subjective user state data 3-60 with the objective occurrence data 3-70* based, at least in part, on a determination (e.g., as made by the sequential pattern determination module 3-236) of at least one sequential pattern associated with the at least one subjective user state and the at least one objective occurrence.

In various alternative implementations, operation 3-702 may include one or more additional operations. For example, in some implementations, operation 3-702 may include an operation 3-704 for correlating the subjective user state data with the objective occurrence data based, at least in part, on a determination of whether the at least one subjective user state occurred within a predefined time increment from incidence of the at least one objective occurrence as depicted in FIG. 3-7a. For instance, the correlation module 3-106 of the computing device 3-10 correlating the subjective user state data 3-60 with the objective occurrence data 3-70* based, at least in part, on a determination by the “within predefined time increment determination” module 3-238 (see FIG. 3-2d) of whether the at least one subjective user state occurred within a predefined time increment from incidence of the at least one objective occurrence.

In some implementations, operation 3-702 may include an operation 3-706 for correlating the subjective user state data with the objective occurrence data based, at least in part, on a determination of whether the at least one subjective user state occurred before, after, or at least partially concurrently with incidence of the at least one objective occurrence as depicted in FIG. 3-7a. For instance, the correlation module 3-106 of the computing device 3-10 correlating the subjective user state data 3-60 with the objective occurrence data 3-70* based, at least in part, on a determination by the temporal relationship determination module 3-239 of whether the at least one subjective user state occurred before, after, or at least partially concurrently with incidence of the at least one objective occurrence.

In some implementations, operation 3-702 may include an operation 3-708 for correlating the subjective user state data with the objective occurrence data based, at least in part, on referencing of historical data as depicted in FIG. 3-7a. For instance, the correlation module 3-106 of the computing device 3-10 correlating the subjective user state data 3-60 with the objective occurrence data 3-70* based, at least in part, on referencing by the historical data referencing module 3-241 of historical data 3-72 (e.g., population trends such as the superior efficacy of ibuprofen as opposed to acetaminophen in reducing toothaches in the general population, user medical data such as genetic, metabolome, or proteome information, historical sequential patterns particular to the user 3-20* or to the overall population such as people having a hangover after drinking excessively, and so forth).

In various implementations, operation 3-708 may include one or more additional operations. For example, in some implementations, operation 3-708 may include an operation 3-710 for correlating the subjective user state data with the objective occurrence data based, at least in part, on the historical data indicative of a link between a subjective user state type and an objective occurrence type as depicted in FIG. 3-7a. For instance, the correlation module 3-106 of the computing device 3-10 correlating the subjective user state data 3-60 with the objective occurrence data 3-70* based, at least in part, on the historical data referencing module 3-241 referencing historical data 3-72 indicative of a link between a subjective user state type and an objective occurrence type (e.g., historical data 3-72 suggests or indicate a link between a person's mental well-being and exercise).

In some instances, operation 3-710 may further include an operation 3-712 for correlating the subjective user state data with the objective occurrence data based, at least in part, on a historical sequential pattern as depicted in FIG. 3-7a. For instance, the correlation module 3-106 of the computing device 3-10 correlating the subjective user state data 3-60 with the objective occurrence data 3-70* based, at least in part, on a historical sequential pattern (e.g., a historical sequential pattern that indicates that people feel more alert after exercising).

In some implementations, operation 3-708 may include an operation 3-714 for correlating the subjective user state data with the objective occurrence data based, at least in part, on historical medical data associated with the user as depicted in FIG. 3-7a. For instance, the correlation module 3-106 of the computing device 3-10 correlating the subjective user state data 3-60 with the objective occurrence data 3-70* based, at least in part, on historical medical data associated with the user 3-20* (e.g., genetic, metabolome, or proteome information or medical records of the user 3-20* or of others related to, for example, diabetes or heart disease).

In some implementations, operation 3-702 may include an operation 3-716 for comparing the at least one sequential pattern to a second sequential pattern to determine whether the at least one sequential pattern at least substantially matches with the second sequential pattern as depicted in FIG. 3-7b. For instance, the sequential pattern comparison module 3-242 of the computing device 3-10 comparing the at least one sequential pattern to a second sequential pattern to determine whether the at least one sequential pattern at least substantially matches with the second sequential pattern.

In various implementations, operation 3-716 may further include an operation 3-718 for comparing the at least one sequential pattern to a second sequential pattern related to at least a second subjective user state associated with the user and a second objective occurrence to determine whether the at least one sequential pattern at least substantially matches with the second sequential pattern as depicted in FIG. 3-7b. For instance, the sequential pattern comparison module 3-242 of the computing device 3-10 comparing the at least one sequential pattern to a second sequential pattern related to at least a second subjective user state associated with the user 3-20* and a second objective occurrence to determine whether the at least one sequential pattern at least substantially matches with the second sequential pattern. In other words, comparing the at least one subjective user state and the at least one objective occurrence associated with the one sequential pattern to the at least a second subjective user state and the at least a second objective occurrence associated with the second sequential pattern in order to determine whether they substantially match (or do not match) as well as to determine whether the temporal or time relationships associated with the one sequential pattern and the second sequential pattern substantially match.

In some implementations, the correlation operation 3-308 of FIG. 3-3 may include an operation 3-720 for correlating the subjective user state data with the objective occurrence data at a server as depicted in FIG. 3-7b. For instance, the correlation module 3-106 of the computing device 3-10 correlating the subjective user state data 3-60 with the objective occurrence data 3-70* when the computing device 3-10 is a network server.

In some implementations, the correlation operation 3-308 may include an operation 3-722 for correlating the subjective user state data with the objective occurrence data at a handheld device as depicted in FIG. 3-7b. For instance, the correlation module 3-106 of the computing device 3-10 correlating the subjective user state data 3-60 with the objective occurrence data 3-70* when the computing device 3-10 is a handheld device.

In some implementations, the correlation operation 3-308 may include an operation 3-724 for correlating the subjective user state data with the objective occurrence data at a peer-to-peer network component device as depicted in FIG. 3-7b. For instance, the correlation module 3-106 of the computing device 3-10 correlating the subjective user state data 3-60 with the objective occurrence data 3-70* when the computing device 3-10 is a peer-to-peer network component device.

Referring to FIG. 3-8 illustrating another operational flow 3-800 in accordance with various embodiments. Operational flow 3-800 includes operations that mirror the operations included in the operational flow 3-300 of FIG. 3-3. These operations include a subjective user state data acquisition operation 3-802, an objective occurrence data solicitation operation 3-804, an objective occurrence data acquisition operation 3-806, and a correlation operation 3-808 that correspond to and mirror the subjective user state data acquisition operation 3-302, the objective occurrence data solicitation operation 3-304, the objective occurrence data acquisition operation 3-306, and the correlation operation 3-308, respectively, of FIG. 3-3.

In addition, operational flow 3-800 includes a presentation operation 3-810 for presenting one or more results of the correlating as depicted in FIG. 3-8. For example, the presentation module 3-108 of the computing device 3-10 presenting (e.g., transmitting via a network interface 3-120 or providing via the user interface 3-122) one or more results of the correlating operation as performed by the correlation module 3-106.

In various embodiments, the presentation operation 3-810 may include one or more additional operations as depicted in FIG. 3-9. For example, in some implementations, the presentation operation 3-810 may include an operation 3-902 for indicating the one or more results of the correlating via a user interface. For instance, the user interface indication module 3-254 (see FIG. 3-2e) of the computing device 3-10 indicating (e.g., displaying or audibly indicating) the one or more results (e.g., in the form of an advisory, a warning, an alert, a prediction, and so forth of a future or past result) of the correlating operation performed by the correlation module 3-106 via a user interface 3-122 (e.g., display monitor, touchscreen, or audio system including one or more speakers).

In some implementations, the presentation operation 3-810 may include an operation 3-904 for transmitting the one or more results of the correlating via a network interface. For instance, the network interface transmission module 3-252 (see FIG. 3-2e) of the computing device 3-10 transmitting the one or more results (e.g., in the form of an advisory, a warning, an alert, a prediction, and so forth of a future or past result) of the correlating operation performed by the correlation module 3-106 via a network interface 3-120 (e.g., NIC).

In some implementations, the presentation operation 3-810 may include an operation 3-906 for presenting an indication of a sequential relationship between the at least one subjective user state and the at least one objective occurrence. For instance, the sequential relationship presentation module 3-256 of the computing device 3-10 presenting (e.g., transmitting via the network interface 3-120 or indicating via user interface 3-122) an indication of a sequential relationship between the at least one subjective user state (e.g., headache) and the at least one objective occurrence (e.g., drinking beer).

In some implementations, the presentation operation 3-810 may include an operation 3-908 for presenting a prediction of a future subjective user state associated with the user resulting from a future objective occurrence. For instance, the prediction presentation module 3-258 of the computing device 3-10 a prediction of a future subjective user state associated with the user 3-20* resulting from a future objective occurrence. An example prediction might state that “if the user drinks five shots of whiskey tonight, the user will have a hangover tomorrow.”

In some implementations, the presentation operation 3-810 may include an operation 3-910 for presenting a prediction of a future subjective user state associated with the user resulting from a past objective occurrence. For instance, the prediction presentation module 3-258 of the computing device 3-10 presenting a prediction of a future subjective user state associated with the user 3-20* resulting from a past objective occurrence. An example prediction might state that “the user will have a hangover tomorrow since the user drank five shots of whiskey tonight.”

In some implementations, the presentation operation 3-810 may include an operation 3-912 for presenting a past subjective user state associated with the user in connection with a past objective occurrence. For instance, the past presentation module 3-260 of the computing device 3-10 presenting a past subjective user state associated with the user 3-20* in connection with a past objective occurrence. An example of such a presentation might state that “the user got depressed the last time it rained.”

In some implementations, the presentation operation 3-810 may include an operation 3-914 for presenting a recommendation for a future action. For instance, the recommendation module 3-262 of the computing device 3-10 presenting a recommendation for a future action. An example recommendation might state that “the user should not drink five shots of whiskey.”

Operation 3-914 may, in some instances, include an additional operation 3-916 for presenting a justification for the recommendation. For instance, the justification module 3-264 of the computing device 3-10 presenting a justification for the recommendation. An example justification might state that “the user should not drink five shots of whiskey because the last time the user drank five shots of whiskey, the user got a hangover.”

### V: Soliciting Data Indicating at Least One Subjective Userstate in Response to Acquisition of Data Indicating at Least One Objective Occurrence

In the following detailed description, reference is made to the accompanying drawings, which form a part hereof. In the drawings, similar symbols typically identify similar components, unless context dictates otherwise. The illustrative embodiments described in the detailed description, drawings, and claims are not meant to be limiting. Other embodiments may be utilized, and other changes may be made, without departing from the spirit or scope of the subject matter presented here.

A recent trend that is becoming increasingly popular in the computing/communication field is to electronically record one's feelings, thoughts, and other aspects of the person's everyday life onto an open diary. One place where such open diaries are maintained are at social networking sites commonly known as “blogs” where one or more users may report or post their thoughts and opinions on various topics, latest news, current events, and various other aspects of the users' everyday life. The process of reporting or posting blog entries is commonly referred to as blogging. Other social networking sites may allow users to update their personal information via, for example, social network status reports in which a user may report or post for others to view the latest status or other aspects of the user.

A more recent development in social networking is the introduction and explosive growth of microblogs in which individuals or users (referred to as “microbloggers”) maintain open diaries at microblog websites (e.g., otherwise known as “twitters”) by continuously or semi-continuously posting microblog entries. A microblog entry (e.g., “tweet”) is typically a short text message that is usually not more than 140 characters long. The microblog entries posted by a microblogger may report on any aspect of the microblogger's daily life.

The various things that are typically posted through microblog entries may be categorized into one of at least two possible categories. The first category of things that may be reported through microblog entries are “objective occurrences” associated with the microblogger. Objective occurrences that are associated with a microblogger may be any characteristic, event, happening, or any other aspects associated with or are of interest to the microblogger that can be objectively reported by the microblogger, a third party, or by a device. These things would include, for example, food, medicine, or nutraceutical intake of the microblogger, certain physical characteristics of the microblogger such as blood sugar level or blood pressure that can be objectively measured, daily activities of the microblogger observable by others or by a device, external events that may not be directly related to the user such as the local weather or the performance of the stock market (which the microblogger may have an interest in), activities of others (e.g., spouse or boss) that may directly or indirectly affect the microblogger, and so forth.

A second category of things that may be reported or posted through microblogging entries include “subjective user states” of the microblogger. Subjective user states of a microblogger include any subjective state or status associated with the microblogger that can only be typically reported by the microblogger (e.g., generally cannot be reported by a third party or by a device). Such states including, for example, the subjective mental state of the microblogger (e.g., “I am feeling happy”), the subjective physical states of the microblogger (e.g., “my ankle is sore” or “my ankle does not hurt anymore” or “my vision is blurry”), and the subjective overall state of the microblogger (e.g., “I'm good” or “I'm well”). Note that the term “subjective overall state” as will be used herein refers to those subjective states that may not fit neatly into the other two categories of subjective user states described above (e.g., subjective mental states and subjective physical states). Although microblogs are being used to provide a wealth of personal information, they have thus far been primarily limited to their use as a means for providing commentaries and for maintaining open diaries.

In accordance with various embodiments, methods, systems, and computer program products are provided for, among other things, soliciting and acquiring subjective user state data including data indicative of at least one subjective user state associated with a user in response to acquisition of objective occurrence data including data indicating at least one objective occurrence. As will be further described herein, in some embodiments, the solicitation of the subjective user state data may, in addition to being prompted by the acquisition of the objective occurrence data, may be prompted based on historical data. Such historical data may be historical data that is associated with the user, associated with a group of users, associated with a segment of the general population, or associated with the general population.

The methods, systems, and computer program products may then correlate the subjective user state data (e.g., data that indicate one or more subjective user states of a user) with the objective occurrence data (e.g., data that indicate one or more objective occurrences associated with the user). By correlating the subjective user state data with the objective occurrence data, a causal relationship between one or more objective occurrences (e.g., cause) and one or more subjective user states (e.g., result) associated with a user (e.g., a blogger or microblogger) may be determined in various alternative embodiments. For example, determining that the last time a user ate a banana (e.g., objective occurrence), the user felt “good” (e.g., subjective user state) or determining whenever a user eats a banana the user always or sometimes feels good. Note that an objective occurrence does not need to occur prior to a corresponding subjective user state but instead, may occur subsequent or concurrently with the incidence of the subjective user state. For example, a person may become “gloomy” (e.g., subjective user state) whenever it is about to rain (e.g., objective occurrence) or a person may become gloomy while (e.g., concurrently) it is raining

In various embodiments, subjective user state data may include data that indicate the occurrence of one or more subjective user states associated with a user. As briefly described above, a “subjective user state” is in reference to any state or status associated with a user (e.g., a blogger or microblogger) at any moment or interval in time that only the user can typically indicate or describe. Such states include, for example, the subjective mental state of the user (e.g., user is feeling sad), the subjective physical state (e.g., physical characteristic) of the user that only the user can typically indicate (e.g., a backache or an easing of a backache as opposed to blood pressure which can be reported by a blood pressure device and/or a third party), and the subjective overall state of the user (e.g., user is “good”).

Examples of subjective mental states include, for example, happiness, sadness, depression, anger, frustration, elation, fear, alertness, sleepiness, and so forth. Examples of subjective physical states include, for example, the presence, easing, or absence of pain, blurry vision, hearing loss, upset stomach, physical exhaustion, and so forth. Subjective overall states may include any subjective user states that cannot be easily categorized as a subjective mental state or as a subjective physical state. Examples of overall states of a user that may be subjective user states include, for example, the user being good, bad, exhausted, lack of rest, wellness, and so forth.

In contrast, “objective occurrence data,” which may also be referred to as “objective context data,” may include data that indicate one or more objective occurrences associated with the user that occurred at particular intervals or points in time. In some embodiments, an objective occurrence may be any physical characteristic, event, happenings, or any other aspect that may be associated with, is of interest to, or may somehow impact a user that can be objectively reported by at least a third party or a sensor device. Note, however, that such objective occurrence data does not have to be actually provided by a sensor device or by a third party, but instead, may be reported by the user himself or herself (e.g., via microblog entries). Examples of objectively reported occurrences that could be indicated by the objective occurrence data include, for example, a user's food, medicine, or nutraceutical intake, the user's location at any given point in time, a user's exercise routine, a user's physiological characteristics such as blood pressure, social or professional activities, the weather at a user's location, activities associated with third parties, occurrence of external events such as the performance of the stock market, and so forth.

The term “correlating” as will be used herein may be in reference to a determination of one or more relationships between at least two variables. Alternatively, the term “correlating” may merely be in reference to the linking or associating of at least two variables. In the following exemplary embodiments, the first variable is subjective user state data that represents at least one subjective user state of a user and the second variable is objective occurrence data that represents at least one objective occurrence. In embodiments where the subjective user state data includes data that indicates multiple subjective user states, each of the subjective user states represented by the subjective user state data may be the same or similar type of subjective user state (e.g., user being happy) at different intervals or points in time. Alternatively, different types of subjective user state (e.g., user being happy and user being sad) may be represented by the subjective user state data. Similarly, in embodiments where multiple objective occurrences are indicated by the objective occurrence data, each of the objective occurrences may represent the same or similar type of objective occurrence (e.g., user exercising) at different intervals or points in time, or alternatively, different types of objective occurrence (e.g., user exercising and user resting).

Various techniques may be employed for correlating subjective user state data with objective occurrence data in various alternative embodiments. For example, in some embodiments, correlating the objective occurrence data with the subjective user state data may be accomplished by determining a sequential pattern associated with at least one subjective user state indicated by the subjective user state data and at least one objective occurrence indicated by the objective occurrence data. In other embodiments, correlating of the objective occurrence data with the subjective user state data may involve determining multiple sequential patterns associated with multiple subjective user states and multiple objective occurrences.

A sequential pattern, as will be described herein, may define time and/or temporal relationships between two or more events (e.g., one or more subjective user states and one or more objective occurrences). In order to determine a sequential pattern, subjective user state data including data indicating occurrence of at least one subjective user state associated with a user may be solicited in response to an acquisition of objective occurrence data including data indicating occurrence of at least one objective occurrence.

For example, if a user (or a third party source such as a content provider or another user) reports that the weather on a particular day (e.g., objective occurrence) was bad (e.g., cloudy weather) then a solicitation for subjective user state data including data indicating occurrence of at least one subjective user state associated with the user on that particular day may be made. Such solicitation of subjective user state data may be prompted based, at least in part, on the reporting of the objective occurrence (e.g., cloudy weather) and based on historical data such as historical data that indicates or suggests that the user tends to get gloomy when the weather is bad (e.g., cloudy) or based on historical data that indicates that people in the general population tend to get gloomy whenever the weather is bad. In some embodiments, such historical data may indicate or define one or more historical sequential patterns of the user or of the general population as they relate to subjective user states and objective occurrences.

As briefly described above, a sequential pattern may merely indicate or represent the temporal relationship or relationships between at least one subjective user state and at least one objective occurrence (e.g., whether the incidence or occurrence of the at least one subjective user state occurred before, after, or at least partially concurrently with the incidence of the at least one objective occurrence). In alternative implementations, and as will be further described herein, a sequential pattern may indicate a more specific time relationship between the incidences of one or more subjective user states and the incidences of one or more objective occurrences. For example, a sequential pattern may represent the specific pattern of events (e.g., one or more objective occurrences and one or more subjective user states) that occurs along a timeline.

The following illustrative example is provided to describe how a sequential pattern associated with at least one subjective user state and at least one objective occurrence may be determined based, at least in part, on the temporal relationship between the incidence of the at least one subjective user state and the incidence of the at least one objective occurrence in accordance with some embodiments. For these embodiments, the determination of a sequential pattern may initially involve determining whether the incidence of the at least one subjective user state occurred within some predefined time increments of the incidence of the one objective occurrence. That is, it may be possible to infer that those subjective user states that did not occur within a certain time period from the incidence of an objective occurrence are not related or are unlikely related to the incidence of that objective occurrence.

For example, suppose a user during the course of a day eats a banana and also has a stomach ache sometime during the course of the day. If the consumption of the banana occurred in the early morning hours but the stomach ache did not occur until late that night, then the stomach ache may be unrelated to the consumption of the banana and may be disregarded. On the other hand, if the stomach ache had occurred within some predefined time increment, such as within 2 hours of consumption of the banana, then it may be concluded that there is a correlation or link between the stomach ache and the consumption of the banana. If so, a temporal relationship between the consumption of the banana and the occurrence of the stomach ache may be determined. Such a temporal relationship may be represented by a sequential pattern. Such a sequential pattern may simply indicate that the stomach ache (e.g., a subjective user state) occurred after (rather than before or concurrently) the consumption of banana (e.g., an objective occurrence).

Other factors may also be referenced and examined in order to determine a sequential pattern and whether there is a relationship (e.g., causal relationship) between an objective occurrence and a subjective user state. These factors may include, for example, historical data (e.g., historical medical data such as genetic data or past history of the user or historical data related to the general population regarding, for example, stomach aches and bananas) as briefly described above. Alternatively, a sequential pattern may be determined for multiple subjective user states and multiple objective occurrences. Such a sequential pattern may particularly map the exact temporal or time sequencing of the various events (e.g., subjective user states and/or objective occurrences). The determined sequential pattern may then be used to provide useful information to the user and/or third parties.

The following is another illustrative example of how subjective user state data may be correlated with objective occurrence data by determining multiple sequential patterns and comparing the sequential patterns with each other. Suppose, for example, a user such as a microblogger reports that the user ate a banana on a Monday. The consumption of the banana, in this example, is a reported first objective occurrence associated with the user. The user then reports that 15 minutes after eating the banana, the user felt very happy. The reporting of the emotional state (e.g., felt very happy) is, in this example, a reported first subjective user state. Thus, the reported incidence of the first objective occurrence (e.g., eating the banana) and the reported incidence of the first subjective user state (user felt very happy) on Monday may be represented by a first sequential pattern.

On Tuesday, the user reports that the user ate another banana (e.g., a second objective occurrence associated with the user). The user then reports that 20 minutes after eating the second banana, the user felt somewhat happy (e.g., a second subjective user state). Thus, the reported incidence of the second objective occurrence (e.g., eating the second banana) and the reported incidence of the second subjective user state (user felt somewhat happy) on Tuesday may be represented by a second sequential pattern. Note that in this example, the occurrences of the first subjective user state and the second subjective user state may be indicated by subjective user state data while the occurrences of the first objective occurrence and the second objective occurrence may be indicated by objective occurrence data.

In a slight variation of the above example, suppose the user had forgotten to report for Tuesday the feeling of being somewhat happy but does report consuming the second banana on Tuesday. This may result in the user being asked, based on the reporting of the user consuming the banana on Tuesday, as to how the user felt on Tuesday or how the user felt after eating the banana on Tuesday. Asking such questions may be prompted both in response to the reporting of the consumption of the second banana on Tuesday (e.g., an objective occurrence) and on referencing historical data (e.g., first sequential pattern derived from Monday's consumption of banana and feeling happy). Upon the user indicating feeling somewhat happy on Tuesday, a second sequential pattern may be determined.

In any event, by comparing the first sequential pattern with the second sequential pattern, the subjective user state data may be correlated with the objective occurrence data. In some implementations, the comparison of the first sequential pattern with the second sequential pattern may involve trying to match the first sequential pattern with the second sequential pattern by examining certain attributes and/or metrics. For example, comparing the first subjective user state (e.g., user felt very happy) of the first sequential pattern with the second subjective user state (e.g., user felt somewhat happy) of the second sequential pattern to see if they at least substantially match or are contrasting (e.g., being very happy in contrast to being slightly happy or being happy in contrast to being sad). Similarly, comparing the first objective occurrence (e.g., eating a banana) of the first sequential pattern may be compared to the second objective occurrence (e.g., eating of another banana) of the second sequential pattern to determine whether they at least substantially match or are contrasting.

A comparison may also be made to determine if the extent of time difference (e.g., 15 minutes) between the first subjective user state (e.g., user being very happy) and the first objective occurrence (e.g., user eating a banana) matches or are at least similar to the extent of time difference (e.g., 20 minutes) between the second subjective user state (e.g., user being somewhat happy) and the second objective occurrence (e.g., user eating another banana). These comparisons may be made in order to determine whether the first sequential pattern matches the second sequential pattern. A match or substantial match would suggest, for example, that a subjective user state (e.g., happiness) is linked to a particular objective occurrence (e.g., consumption of banana).

As briefly described above, the comparison of the first sequential pattern with the second sequential pattern may include a determination as to whether, for example, the respective subjective user states and the respective objective occurrences of the sequential patterns are contrasting subjective user states and/or contrasting objective occurrences. For example, suppose in the above example the user had reported that the user had eaten a whole banana on Monday and felt very energetic (e.g., first subjective user state) after eating the whole banana (e.g., first objective occurrence). Suppose that the user also reported that on Tuesday he ate a half a banana instead of a whole banana and only felt slightly energetic (e.g., second subjective user state) after eating the half banana (e.g., second objective occurrence). In this scenario, the first sequential pattern (e.g., feeling very energetic after eating a whole banana) may be compared to the second sequential pattern (e.g., feeling slightly energetic after eating only a half of a banana) to at least determine whether the first subjective user state (e.g., being very energetic) and the second subjective user state (e.g., being slightly energetic) are contrasting subjective user states. Another determination may also be made during the comparison to determine whether the first objective occurrence (eating a whole banana) is in contrast with the second objective occurrence (e.g., eating a half of a banana).

In doing so, an inference may be made that eating a whole banana instead of eating only a half of a banana makes the user happier or eating more banana makes the user happier. Thus, the word “contrasting” as used here with respect to subjective user states refers to subjective user states that are the same type of subjective user states (e.g., the subjective user states being variations of a particular type of subjective user states such as variations of subjective mental states). Thus, for example, the first subjective user state and the second subjective user state in the previous illustrative example are merely variations of subjective mental states (e.g., happiness). Similarly, the use of the word “contrasting” as used here with respect to objective occurrences refers to objective states that are the same type of objective occurrences (e.g., consumption of food such as banana).

As those skilled in the art will recognize, a stronger correlation between the subjective user state data and the objective occurrence data could be obtained if a greater number of sequential patterns (e.g., if there was a third sequential pattern, a fourth sequential pattern, and so forth, that indicated that the user became happy or happier whenever the user ate bananas) are used as a basis for the correlation. Note that for ease of explanation and illustration, each of the exemplary sequential patterns to be described herein will be depicted as a sequential pattern of an occurrence of a single subjective user state and an occurrence of a single objective occurrence. However, those skilled in the art will recognize that a sequential pattern, as will be described herein, may also be associated with occurrences of multiple objective occurrences and/or multiple subjective user states. For example, suppose the user had reported that after eating a banana, he had gulped down a can of soda. The user then reported that he became happy but had an upset stomach. In this example, the sequential pattern associated with this scenario will be associated with two objective occurrences (e.g., eating a banana and drinking a can of soda) and two subjective user states (e.g., user having an upset stomach and feeling happy).

In some embodiments, and as briefly described earlier, the sequential patterns derived from subjective user state data and objective occurrence data may be based on temporal relationships between objective occurrences and subjective user states. For example, whether a subjective user state occurred before, after, or at least partially concurrently with an objective occurrence. For instance, a plurality of sequential patterns derived from subjective user state data and objective occurrence data may indicate that a user always has a stomach ache (e.g., subjective user state) after eating a banana (e.g., first objective occurrence).

FIGS. 4-1a and 4-1b illustrate an example environment in accordance with various embodiments. In the illustrated environment, an exemplary system 4-100 may include at least a computing device 4-10 (see FIG. 4-1b) that may be employed in order to, among other things, acquire objective occurrence data 4-70* including data indicating occurrence of at least one objective occurrence, solicit and acquire subjective user state data 4-60 including data indicating occurrence of at least one subjective user state 4-60a associated with a user 4-20* in response to the acquisition of the objective occurrence data 4-70*, and to correlate the subjective user state data 4-60 with the objective occurrence data 4-70*. Note that in the following, “*” indicates a wildcard. Thus, user 4-20* may indicate a user 4-20a or a user 4-20b of FIGS. 4-1a and 4-1b.

In some embodiments, the computing device 4-10 may be a network server in which case the computing device 4-10 may communicate with a user 4-20a via a mobile device 4-30 and through a wireless and/or wired network 4-40. A network server, as will be described herein, may be in reference to a server located at a single network site or located across multiple network sites or a conglomeration of servers located at multiple network sites. The mobile device 4-30 may be a variety of computing/communication devices including, for example, a cellular phone, a personal digital assistant (PDA), a laptop, a desktop, or other types of computing/communication device that can communicate with the computing device 4-10.

In alternative embodiments, the computing device 4-10 may be a local computing device that communicates directly with a user 4-20b. For these embodiments, the computing device 4-10 may be any type of handheld device such as a cellular telephone, a PDA, or other types of computing/communication devices such as a laptop computer, a desktop computer, and so forth. In various embodiments, the computing device 4-10 may be a peer-to-peer network component device. In some embodiments, the computing device 4-10 may operate via a web 2.0 construct.

In embodiments where the computing device 4-10 is a server, the computing device 4-10 may obtain the subjective user state data 4-60 indirectly from a user 4-20a via a network interface 4-120. In alternative embodiments in which the computing device 4-10 is a local device such as a handheld device (e.g., cellular telephone, personal digital assistant, etc.), the subjective user state data 4-60 may be directly obtained from a user 4-20b via a user interface 4-122. As will be further described, the computing device 10 may acquire the objective occurrence data 4-70* from one or more alternative sources.

For ease of illustration and explanation, the following systems and operations to be described herein will be generally described in the context of the computing device 4-10 being a network server. However, those skilled in the art will recognize that these systems and operations may also be implemented when the computing device 4-10 is a local device such as a handheld device that may communicate directly with a user 4-20b.

Assuming that the computing device 4-10 is a server, the computing device 4-10, in various implementations, may be configured to acquire objective occurrence data 4-70* including data indicating incidence or occurrence of at least one objective occurrence via a network interface 4-120 or via a user interface 4-122. In some implementations, the objective occurrence data 4-70* may further include additional data that may indicate occurrences of one or more additional objective occurrences (e.g., data indicating occurrence of at least a second objective occurrence). The objective occurrence data 4-70* may be provided by a user 4-20*, by one or more third parties 4-50 (e.g., third party sources), or by one or more sensors 4-35.

For example, in some embodiments, objective occurrence data 4-70a may be acquired from one or more third parties 4-50. Examples of third parties 4-50 include, for example, other users, medical entities such as medical or dental clinics and hospitals, content providers, employers, fitness centers, social organizations, and so forth.

In some embodiments, objective occurrence data 4-70b may be acquired from one or more sensors 4-35 that may be designed for sensing or monitoring various aspects associated with the user 4-20a (or user 4-20b). For example, in some implementations, the one or more sensors 4-35 may include a global positioning system (GPS) device for determining the location of the user 4-20a and/or a physical activity sensor for measuring physical activities of the user 4-20a. Examples of a physical activity sensor include, for example, a pedometer for measuring physical activities of the user 4-20a. In certain implementations, the one or more sensors 4-35 may include one or more physiological sensor devices for measuring physiological characteristics of the user 4-20a. Examples of physiological sensor devices include, for example, a blood pressure monitor, a heart rate monitor, a glucometer, and so forth. In some implementations, the one or more sensors 4-35 may include one or more image capturing devices such as a video or digital camera.

In some embodiments, objective occurrence data 4-70c may be acquired from a user 4-20a via the mobile device 4-30 (or from user 4-20b via user interface 4-122). For these embodiments, the objective occurrence data 4-70c may be in the form of blog entries (e.g., microblog entries), status reports, or other types of electronic entries (e.g., diary or calendar entries) or messages. In various implementations, the objective occurrence data 4-70c acquired from the user 4-20a may indicate, for example, activities (e.g., exercise or food or medicine intake) performed by the user 4-20a, certain physical characteristics (e.g., blood pressure or location) associated with the user 4-20a, or other aspects associated with the user 4-20a that the user 4-20a can report objectively. The objective occurrence data 4-70c may be in the form of a text data, audio or voice data, or image data.

The computing device 4-10 may also be configured to solicit subjective user state data 4-60 including data indicating occurrence of at least one subjective user state 4-60a. Such a solicitation of the subjective user state data 4-60 may be prompted in response to the acquisition of objective occurrence data 4-70* and/or in response to referencing of historical data 4-72. The solicitation of the subjective user state 4-60 (e.g., the data indicating the occurrence of the at least one subjective user state 4-60a) may be made through a network interface 4-120 or through the user interface 4-122. As will be further described, the data indicating the occurrence of the at least one subjective user state 4-60a may be solicited from a user 4-20*, from a mobile device 4-30 (which may already have been provided with such data from the user 4-20*), or from one or more network servers (not depicted). Such a solicitation may be accomplished in a number of ways depending on the specific circumstances (e.g., whether the computing device 4-10 is a server or a local device). Examples of how subjective user state data 4-60 including data indicating occurrence of at least one subjective user state 4-60a could be solicited include, for example, transmitting via a network interface 4-120 a request for subjective user state data 4-60, indicating via a user interface 4-122 a request for subjective user state data 4-60, configuring or activating a mobile device 4-30 or a network server to provide such data, and so forth.

After soliciting for the subjective user state data 4-60, the computing device 4-10 may be configured to acquire the subjective user state data 4-60 from one or more sources (e.g., user 4-20*, mobile device 4-30, and so forth). In various embodiments, the subjective user state data 4-60 acquired by the computing device 4-10 may include data indicating occurrence of at least one subjective user state 4-60a associated with a user 4-20a (or with user 4-20b in the case where the computing device 4-10 is a local device). The acquired subjective user state data 4-60 may additionally include data indicative of occurrence of one or more additional subjective user states associated with the user 4-20a (or user 4-20b) including data indicating occurrence of at least a second subjective user state 4-60b associated with the user 4-20a (or user 4-20b). Note that in various implementations, the data indicating occurrence of at least a second subjective user state 4-60b may or may not have been solicited.

In various embodiments, the data indicating occurrence of at least one subjective user state 4-60a, as well as the data indicating occurrence of at least a second subjective user state 4-60b, may be acquired in the form of blog entries (e.g., microblog entries), status reports (e.g., social networking status reports), electronic messages (email, text messages, instant messages, etc.) or other types of electronic messages or documents. The data indicating occurrence of at least one subjective user state 4-60a and the data indicating occurrence of at least a second subjective user state 4-60b may, in some instances, indicate the same, contrasting, or completely different subjective user states associated with a user 4-20*.

Examples of subjective user states that may be indicated by the subjective user state data 4-60 include, for example, subjective mental states of a user 4-20* (e.g., user 4-20* is sad or angry), subjective physical states of the user 4-20* (e.g., physical or physiological characteristic of the user 4-20* such as the presence, absence, elevating, or easing of a stomach ache or headache), subjective overall states of the user 4-20* (e.g., user 4-20* is “well”), and/or other subjective user states that only the user 4-20* can typically indicate.

After acquiring the subjective user state data 4-60 including data indicating occurrence of at least one subjective user state 4-60a and the objective occurrence data 4-70* including data indicating occurrence of at least one objective occurrence, the computing device 4-10 may be configured to correlate the acquired subjective user data 4-60 with the acquired objective occurrence data 4-70* by, for example, determining whether there is a sequential relationship between the one or more subjective user states as indicated by the acquired subjective user state data 4-60 and the one or more objective occurrences indicated by the acquired objective occurrence data 4-70*.

In some embodiments, and as will be further explained in the operations and processes to be described herein, the computing device 4-10 may be further configured to present one or more results of correlation. In various embodiments, the one or more correlation results 4-80 may be presented to a user 4-20* and/or to one or more third parties 4-50 in various forms (e.g., in the form of an advisory, a warning, a prediction, and so forth). The one or more third parties 4-50 may be other users (e.g., microbloggers), health care providers, advertisers, and/or content providers.

As illustrated in FIG. 4-1b, computing device 4-10 may include one or more components and/or sub-modules. For instance, in various embodiments, computing device 4-10 may include an objective occurrence data acquisition module 4-102, a subjective user state data solicitation module 4-103, a subjective user state data acquisition module 4-104, a correlation module 4-106, a presentation module 4-108, a network interface 4-120 (e.g., network interface card or NIC), a user interface 4-122 (e.g., a display monitor, a touchscreen, a keypad or keyboard, a mouse, an audio system including a microphone and/or speakers, an image capturing system including digital and/or video camera, and/or other types of interface devices), one or more applications 4-126 (e.g., a web 2.0 application, a voice recognition application, and/or other applications), and/or memory 4-140, which may include historical data 4-72.

FIG. 4-2a illustrates particular implementations of the objective occurrence data acquisition module 4-102 of the computing device 4-10 of FIG. 4-1b. In brief, the objective occurrence data acquisition module 4-102 may be designed to, among other things, acquire objective occurrence data 4-70* including data indicating occurrence of at least one objective occurrence. As further illustrated, objective occurrence data acquisition module 4-102 may include an objective occurrence data reception module 4-202 for receiving the objective occurrence data 4-70* from a user 4-20*, from one or more third parties 4-50 (e.g., one or more third party sources), or from one or more sensors 4-35.

In some implementations, the objective occurrence data reception module 4-202 may further include a user interface data reception module 4-204 and/or a network interface data reception module 4-206. In brief, and as will be further described in the processes and operations to be described herein, the user interface data reception module 4-204 may be configured to receive objective occurrence data 4-70* via a user interface 4-122 (e.g., a display monitor, a keyboard, a touch screen, a mouse, a keypad, a microphone, a camera, and/or other interface devices) such as in the case where the computing device 4-10 is a local device to be used directly by a user 4-20b. In contrast, the network interface data reception module 4-206 may be configured to receive objective occurrence data 4-70* from a wireless and/or wired network 4-40 via a network interface 4-120 (e.g., network interface card or NIC) such as in the case where the computing device 4-10 is a network server.

In various embodiments, the objective occurrence data acquisition module 4-102 may include a time data acquisition module 4-208 for acquiring time and/or temporal elements associated with one or more objective occurrences. For these embodiments, the time and/or temporal elements (e.g., time stamps, time interval indicators, and/or temporal relationship indicators) acquired by the time data acquisition module 4-208 may be useful for, among other things, determining one or more sequential patterns associated with subjective user states and objective occurrences as will be further described herein.

In some implementations, the time data acquisition module 4-208 may include a time stamp acquisition module 4-210 for acquiring (e.g., either by receiving or generating) one or more time stamps associated with one or more objective occurrences. In the same or different implementations, the time data acquisition module 4-208 may include a time interval acquisition module 4-212 for acquiring (e.g., either by receiving or generating) indications of one or more time intervals associated with one or more objective occurrences. In the same or different implementations, the time data acquisition module 4-208 may include a temporal relationship acquisition module 4-214 for acquiring, for example, indications of temporal relationships between subjective user states and objective occurrences. For example, acquiring an indication that an objective occurrence such as “eating lunch” occurred before, after, or at least partially concurrently with incidence of a subjective user state such as a “stomach ache.”

FIG. 4-2b illustrates particular implementations of the subjective user state data solicitation module 4-103 of the computing device 4-10 of FIG. 4-1b. The subjective user state data solicitation module 4-103 may be configured or designed to solicit, in response to acquisition of objective occurrence data 4-70* including data indicating occurrence of at least one objective occurrence, subjective user state data 4-60 including data indicating occurrence of at least one subjective user state 4-60a. In various embodiments, the subjective user state data 4-60 may be solicited from a user 4-20*, from a mobile device 4-30 (e.g., in the case where the mobile device 4-30 has already received such data from a user 4-20a), from one or more network servers (e.g., in the case where such data has already been provided to the network servers), or from one or more third party sources (e.g., in the case where such data has already been provided to the one or more third party sources such as network service providers). The solicitation may be made via, for example, network interface 4-120 or via the user interface 4-122 (e.g., when the computing device 4-10 is a local device such as a handheld held device to be used directly by a user 4-20b).

In various embodiments, the subjective user state data solicitation module 4-103 may be configured to solicit data indicating occurrence of at least one subjective user state 4-60a associated with a user 4-20* that occurred at a specified point in time or occurred at a specified time interval. In some implementations, the solicitation of the subjective user state data 4-60 including data indicating occurrence of at least one subjective user state 4-60a by the subjective user state data solicitation module 4-103 may be prompted by the acquisition of objective occurrence data 4-70* and/or as a result of referencing historical data 4-72 (which may be stored in memory 4-140).

In some implementations, referencing of the historical data 4-72 by the subjective user state data solicitation module 4-103 may prompt the solicitation of particular data indicating occurrence of a particular or a particular type of subjective user state associated with a user 4-20*. For example, in some implementations, the subjective user state data solicitation module 4-103 may solicit data indicating occurrence of a subjective mental state (e.g., soliciting data that indicates the happiness level of the user 4-20*), a subjective physical state (e.g., soliciting data that indicates the level of back pain of the user 4-20*), or a subjective overall state (e.g., soliciting data that indicates user status such as “good” or “bad”) of a user 4-20*.

In some implementations, the historical data 4-72 to be referenced may be data that may indicate a link between a subjective user state type and an objective occurrence type. In the same or different implementations, the historical data 4-72 to be referenced may include one or more historical sequential patterns associated with the user 4-20*, a group of users, or the general population. In the same or different implementations, the historical data 4-72 to be referenced may include historical medical data associated with the user 4-20*, associated with other users, or associated with the general population. The relevance of the historical data 4-72 with respect to the solicitation operations performed by the subjective user state data solicitation module 4-103 will be apparent in the processes and operations to be described herein.

In order to perform the various functions described herein, the subjective user state data solicitation module 4-103 may include, among other things, a network interface solicitation module 4-215, a user interface solicitation module 4-216, a requesting module 4-217, a configuration module 4-218, and/or a directing/instructing module 4-219. In brief, the network interface solicitation module 4-215 may be employed in order to solicit subjective user state data 4-60 via a network interface 4-120. In some implementations, the network interface solicitation module 4-215 may further include a transmission module 4-220 for transmitting a request for subjective user state data 4-60 including data indicating occurrence of at least one subjective user state 4-60a.

In contrast, the user interface solicitation module 4-216 may be employed in order to, among other things, solicit subjective user state data 4-60 via user interface 4-122 from, for example, a user 4-20b. In some implementations, the user interface solicitation module 4-216 may further include an indication module 4-221 for, for example, audibly or visually indicating via a user interface 4-122 (e.g., an audio system including a speaker and/or a display system such as a display monitor) a request for subjective user state data 4-60 including data indicating occurrence of at least one subjective user state 4-60a. The requesting module 4-217 may be employed in order to, among other things, request to be provided with or to have access to subjective user state data 4-60 including data indicating occurrence of at least one subjective user state 4-60a associated with a user 4-20*. The configuration module 4-218 may be employed in order to configure, for example, a mobile device 4-30 or one or more network servers (not depicted) to provide the subjective user state data 4-60 including the data indicating occurrence of at least one subjective user state 4-60a. The directing/instructing module 4-219 may be employed in order to direct and/or instruct, for example, a mobile device 4-30 or one or more network servers (not depicted) to provide the subjective user state data 4-60 including the data indicating occurrence of at least one subjective user state 4-60a.

Referring now to FIG. 4-2c illustrating particular implementations of the subjective user state data acquisition module 4-104 of the computing device 4-10 of FIG. 4-1b. In brief, the subjective user state data acquisition module 4-104 may be designed to, among other things, acquire subjective user state data 4-60 including data indicating at least one subjective user state 4-60a associated with a user 4-20*. In various embodiments, the subjective user state data acquisition module 4-104 may include a reception module 4-224 configured to receive subjective user state data 4-60. In some embodiments, the reception module 4-224 may further include a subjective user state data user interface reception module 4-226 for receiving, via a user interface 4-122, subjective user state data 4-60. In the same or different embodiments, the reception module 4-224 may include a subjective user state data network interface reception module 4-227 for receiving, via a network interface 4-120, subjective user state data 4-60.

In various embodiments, the subjective user state data acquisition module 104 may include a time data acquisition module 4-228 configured to acquire (e.g., receive or generate) time and/or temporal elements associated with one or more subjective user states associated with a user 4-20*. For these embodiments, the time and/or temporal elements (e.g., time stamps, time intervals, and/or temporal relationships) may be useful for determining sequential patterns associated with objective occurrences and subjective user states.

In some implementations, the time data acquisition module 4-228 may include a time stamp acquisition module 4-230 for acquiring (e.g., either by receiving or by generating) one or more time stamps associated with one or more subjective user states associated with a user 4-20*. In the same or different implementations, the time data acquisition module 4-228 may include a time interval acquisition module 4-231 for acquiring (e.g., either by receiving or generating) indications of one or more time intervals associated with one or more subjective user states associated with a user 4-20*. In the same or different implementations, the time data acquisition module 4-228 may include a temporal relationship acquisition module 4-232 for acquiring indications of temporal relationships between objective occurrences and subjective user states (e.g., an indication that a subjective user state associated with a user 4-20* occurred before, after, or at least partially concurrently with incidence of an objective occurrence).

Turning now to FIG. 4-2d illustrating particular implementations of the correlation module 4-106 of the computing device 4-10 of FIG. 4-1b. The correlation module 4-106 may be configured to, among other things, correlate subjective user state data 4-60 with objective occurrence data 4-70* based, at least in part, on a determination of at least one sequential pattern of at least one objective occurrence and at least one subjective user state. In various embodiments, the correlation module 4-106 may include a sequential pattern determination module 4-236 configured to determine one or more sequential patterns of one or more subjective user states and one or more objective occurrences.

The sequential pattern determination module 4-236, in various implementations, may include one or more sub-modules that may facilitate in the determination of one or more sequential patterns. As depicted, the one or more sub-modules that may be included in the sequential pattern determination module 4-236 may include, for example, a “within predefined time increment determination” module 4-238, a temporal relationship determination module 4-239, a subjective user state and objective occurrence time difference determination module 4-240, and/or a historical data referencing module 4-241. In brief, the within predefined time increment determination module 4-238 may be configured to determine whether at least one subjective user state of a user 4-20* occurred within a predefined time increment from an incidence of at least one objective occurrence. For example, determining whether a user 4-20* “feeling bad” (i.e., a subjective user state) occurred within ten hours (i.e., predefined time increment) of eating a large chocolate sundae (i.e., an objective occurrence). Such a process may be used in order to filter out events that are likely not related or to facilitate in determining the strength of correlation between subjective user state data 4-60 and objective occurrence data 4-70*. For example, if the user 4-20* “feeling bad” occurred more than 10 hours after eating the chocolate sundae, then this may indicate a weaker correlation between a subjective user state (e.g., feeling bad) and an objective occurrence (e.g., eating a chocolate sundae).

The temporal relationship determination module 4-239 of the sequential pattern determination module 4-236 may be configured to determine the temporal relationships between one or more subjective user states and one or more objective occurrences. For example, this may entail determining whether a particular subjective user state (e.g., sore back) occurred before, after, or at least partially concurrently with incidence of an objective occurrence (e.g., sub-freezing temperature).

The subjective user state and objective occurrence time difference determination module 4-240 of the sequential pattern determination module 4-236 may be configured to determine the extent of time difference between the incidence of at least one subjective user state and the incidence of at least one objective occurrence. For example, determining how long after taking a particular brand of medication (e.g., objective occurrence) did a user 4-20* feel “good” (e.g., subjective user state).

The historical data referencing module 4-241 of the sequential pattern determination module 4-236 may be configured to reference historical data 4-72 in order to facilitate in determining sequential patterns. For example, in various implementations, the historical data 4-72 that may be referenced may include, for example, general population trends (e.g., people having a tendency to have a hangover after drinking or ibuprofen being more effective than aspirin for toothaches in the general population), medical information such as genetic, metabolome, or proteome information related to the user 4-20* (e.g., genetic information of the user 4-20* indicating that the user 4-20* is susceptible to a particular subjective user state in response to occurrence of a particular objective occurrence), or historical sequential patterns such as known sequential patterns of the general population or of the user 4-20* (e.g., people tending to have difficulty sleeping within five hours after consumption of coffee). In some instances, such historical data 4-72 may be useful in associating one or more subjective user states with one or more objective occurrences.

In some embodiments, the correlation module 4-106 may include a sequential pattern comparison module 4-242. As will be further described herein, the sequential pattern comparison module 4-242 may be configured to compare two or more sequential patterns with each other to determine, for example, whether the sequential patterns at least substantially match each other or to determine whether the sequential patterns are contrasting sequential patterns.

As depicted in FIG. 4-2d, in various implementations, the sequential pattern comparison module 4-242 may further include one or more sub-modules that may be employed in order to, for example, facilitate in the comparison of different sequential patterns. For example, in various implementations, the sequential pattern comparison module 4-242 may include one or more of a subjective user state equivalence determination module 4-243, an objective occurrence equivalence determination module 4-244, a subjective user state contrast determination module 4-245, an objective occurrence contrast determination module 4-246, a temporal relationship comparison module 4-247, and/or an extent of time difference comparison module 4-248.

The subjective user state equivalence determination module 4-243 of the sequential pattern comparison module 4-242 may be configured to determine whether subjective user states associated with different sequential patterns are equivalent. For example, the subjective user state equivalence determination module 4-243 may determine whether a first subjective user state of a first sequential pattern is equivalent to a second subjective user state of a second sequential pattern. For instance, suppose a user 4-20* reports that on Monday he had a stomach ache (e.g., first subjective user state) after eating at a particular restaurant (e.g., a first objective occurrence), and suppose further that the user 4-20* again reports having a stomach ache (e.g., a second subjective user state) after eating at the same restaurant (e.g., a second objective occurrence) on Tuesday, then the subjective user state equivalence determination module 4-243 may be employed in order to compare the first subjective user state (e.g., stomach ache) with the second subjective user state (e.g., stomach ache) to determine whether they are equivalent.

In contrast, the objective occurrence equivalence determination module 4-244 of the sequential pattern comparison module 4-242 may be configured to determine whether objective occurrences of different sequential patterns are equivalent. For example, the objective occurrence equivalence determination module 4-244 may determine whether a first objective occurrence of a first sequential pattern is equivalent to a second objective occurrence of a second sequential pattern. For instance, for the above example the objective occurrence equivalence determination module 4-244 may compare eating at the particular restaurant on Monday (e.g., first objective occurrence) with eating at the same restaurant on Tuesday (e.g., second objective occurrence) in order to determine whether the first objective occurrence is equivalent to the second objective occurrence.

In some implementations, the sequential pattern comparison module 4-242 may include a subjective user state contrast determination module 4-245 that may be configured to determine whether subjective user states associated with different sequential patterns are contrasting subjective user states. For example, the subjective user state contrast determination module 4-245 may determine whether a first subjective user state of a first sequential pattern is a contrasting subjective user state from a second subjective user state of a second sequential pattern. To illustrate, suppose a user 4-20* reports that he felt very “good” (e.g., first subjective user state) after jogging for an hour (e.g., first objective occurrence) on Monday, but reports that he felt “bad” (e.g., second subjective user state) when he did not exercise (e.g., second objective occurrence) on Tuesday, then the subjective user state contrast determination module 4-245 may compare the first subjective user state (e.g., feeling good) with the second subjective user state (e.g., feeling bad) to determine that they are contrasting subjective user states.

In some implementations, the sequential pattern comparison module 4-242 may include an objective occurrence contrast determination module 4-246 that may be configured to determine whether objective occurrences of different sequential patterns are contrasting objective occurrences. For example, the objective occurrence contrast determination module 4-246 may determine whether a first objective occurrence of a first sequential pattern is a contrasting objective occurrence from a second objective occurrence of a second sequential pattern. For instance, for the above example, the objective occurrence contrast determination module 4-246 may compare the “jogging” on Monday (e.g., first objective occurrence) with the “no jogging” on Tuesday (e.g., second objective occurrence) in order to determine whether the first objective occurrence is a contrasting objective occurrence from the second objective occurrence. Based on the contrast determination, an inference may be made that the user 4-20* may feel better by jogging rather than by not jogging at all.

In some embodiments, the sequential pattern comparison module 4-242 may include a temporal relationship comparison module 4-247 that may be configured to make comparisons between different temporal relationships of different sequential patterns. For example, the temporal relationship comparison module 4-247 may compare a first temporal relationship between a first subjective user state and a first objective occurrence of a first sequential pattern with a second temporal relationship between a second subjective user state and a second objective occurrence of a second sequential pattern in order to determine whether the first temporal relationship at least substantially matches the second temporal relationship.

For example, suppose in the above example the user 4-20* eating at the particular restaurant (e.g., first objective occurrence) and the subsequent stomach ache (e.g., first subjective user state) on Monday represents a first sequential pattern while the user 4-20* eating at the same restaurant (e.g., second objective occurrence) and the subsequent stomach ache (e.g., second subjective user state) on Tuesday represents a second sequential pattern. In this example, the occurrence of the stomach ache after (rather than before or concurrently) eating at the particular restaurant on Monday represents a first temporal relationship associated with the first sequential pattern while the occurrence of a second stomach ache after (rather than before or concurrently) eating at the same restaurant on Tuesday represents a second temporal relationship associated with the second sequential pattern. Under such circumstances, the temporal relationship comparison module 4-247 may compare the first temporal relationship to the second temporal relationship in order to determine whether the first temporal relationship and the second temporal relationship at least substantially match (e.g., stomachaches in both temporal relationships occurring after eating at the restaurant). Such a match may result in the inference that a stomach ache is associated with eating at the particular restaurant.

In some implementations, the sequential pattern comparison module 4-242 may include an extent of time difference comparison module 4-248 that may be configured to compare the extent of time differences between incidences of subjective user states and incidences of objective occurrences of different sequential patterns. For example, the extent of time difference comparison module 4-248 may compare the extent of time difference between incidence of a first subjective user state and incidence of a first objective occurrence of a first sequential pattern with the extent of time difference between incidence of a second subjective user state and incidence of a second objective occurrence of a second sequential pattern. In some implementations, the comparisons may be made in order to determine that the extent of time differences of the different sequential patterns at least substantially or proximately match.

In some embodiments, the correlation module 4-106 may include a strength of correlation determination module 4-250 for determining a strength of correlation between subjective user state data 4-60 and objective occurrence data 4-70* associated with a user 4-20*. In some implementations, the strength of correlation may be determined based, at least in part, on the results provided by the other sub-modules of the correlation module 4-106 (e.g., the sequential pattern determination module 4-236, the sequential pattern comparison module 4-242, and their sub-modules).

FIG. 4-2e illustrates particular implementations of the presentation module 4-108 of the computing device 4-10 of FIG. 4-1b. In various implementations, the presentation module 4-108 may be configured to present, for example, one or more results of the correlation operations performed by the correlation module 4-106. The one or more results may be presented in different ways in various alternative embodiments. For example, in some implementations, the presentation of the one or more results may entail the presentation module 4-108 presenting to the user 4-20* (or some other third party 4-50) an indication of a sequential relationship between a subjective user state and an objective occurrence associated with the user 4-20* (e.g., “whenever you eat a banana, you have a stomach ache). In alternative implementations, other ways of presenting the results of the correlation may be employed. For example, in various alternative implementations, a notification may be provided to notify past tendencies or patterns associated with a user 4-20*. In some implementations, a notification of a possible future outcome may be provided. In other implementations, a recommendation for a future course of action based on past patterns may be provided. These and other ways of presenting the correlation results will be described in the processes and operations to be described herein.

In various implementations, the presentation module 4-108 may include a network interface transmission module 4-252 for transmitting one or more results of the correlation performed by the correlation module 4-106 via network interface 4-120. For example, in the case where the computing device 4-10 is a server, the network interface transmission module 4-252 may be configured to transmit to the user 4-20a or a third party 4-50 the one or more results of the correlation performed by the correlation module 4-106 via a network interface 4-120.

In the same or different implementations, the presentation module 4-108 may include a user interface indication module 4-254 for indicating the one or more results of the correlation operations performed by the correlation module 4-106 via a user interface 4-122. For example, in the case where the computing device 4-10 is a local device, the user interface indication module 4-254 may be configured to indicate to a user 4-20b the one or more results of the correlation performed by the correlation module 4-106 via a user interface 4-122 (e.g., a display monitor, a touchscreen, an audio system including at least a speaker, and/or other interface devices).

The presentation module 4-108 may further include one or more sub-modules to present the one or more results of the correlation operations performed by the correlation module 4-106 in different forms. For example, in some implementations, the presentation module 4-108 may include a sequential relationship presentation module 4-256 configured to present an indication of a sequential relationship between at least one subjective user state of a user 4-20* and at least one objective occurrence. In the same or different implementations, the presentation module 4-108 may include a prediction presentation module 4-258 configured to present a prediction of a future subjective user state of a user 4-20* resulting from a future objective occurrence associated with the user 4-20*. In the same or different implementations, the prediction presentation module 4-258 may also be designed to present a prediction of a future subjective user state of a user 4-20* resulting from a past objective occurrence associated with the user 4-20*. In some implementations, the presentation module 4-108 may include a past presentation module 4-260 that is designed to present a past subjective user state of a user 4-20* in connection with a past objective occurrence associated with the user 4-20*.

In some implementations, the presentation module 4-108 may include a recommendation module 4-262 configured to present a recommendation for a future action based, at least in part, on the results of a correlation of subjective user state data 4-60 with objective occurrence data 4-70* as performed by the correlation module 4-106. In certain implementations, the recommendation module 4-262 may further include a justification module 4-264 for presenting a justification for the recommendation presented by the recommendation module 4-262. In some implementations, the presentation module 4-108 may include a strength of correlation presentation module 4-266 for presenting an indication of a strength of correlation between subjective user state data 4-60 and objective occurrence data 4-70*.

In various embodiments, the computing device 4-10 of FIG. 4-1b may include a network interface 4-120 that may facilitate in communicating with a user 4-20a, with one or more sensors 4-35, and/or with one or more third parties 4-50. For example, in embodiments where the computing device 4-10 is a server, the computing device 4-10 may include a network interface 4-120 that may be configured to receive from the user 4-20a subjective user state data 4-60. In some embodiments, objective occurrence data 4-70a, 4-70b, and/or 4-70c may also be received through the network interface 4-120. Examples of a network interface 4-120 includes, for example, a network interface card (NIC).

The computing device 4-10 may also include a memory 4-140 for storing various data. For example, in some embodiments, memory 4-140 may be employed in order to store historical data 4-72. In some implementations, the historical data 4-72 may include historical subjective user state data of a user 4-20* that may indicate one or more past subjective user states of the user 4-20* and historical objective occurrence data that may indicate one or more past objective occurrences. In same or different implementations, the historical data 4-72 may include historical medical data of a user 4-20* (e.g., genetic, metoblome, proteome information), population trends, historical sequential patterns derived from general population, and so forth.

In various embodiments, the computing device 4-10 may include a user interface 4-122 to communicate directly with a user 4-20b. For example, in embodiments in which the computing device 4-10 is a local device such as a handheld device (e.g., cellular telephone, PDA, and so forth), the user interface 4-122 may be configured to directly receive from the user 4-20b subjective user state data 4-60 and/or objective occurrence data 4-70*. In some implementations, the user interface 4-122 may also be designed to visually or audibly present the results of correlating subjective user state data 4-60 and objective occurrence data 4-70*. The user interface 4-122 may include, for example, one or more of a display monitor, a touch screen, a key board, a key pad, a mouse, an audio system including a microphone and/or one or more speakers, an imaging system including a digital or video camera, and/or other user interface devices.

FIG. 4-2e illustrates particular implementations of the one or more applications 4-126 of FIG. 4-1b. For these implementations, the one or more applications 4-126 may include, for example, one or more communication applications 4-267 such as a text messaging application and/or an audio messaging application including a voice recognition system application. In some implementations, the one or more applications 4-126 may include a web 2.0 application 4-268 to facilitate communication via, for example, the World Wide Web. The functional roles of the various components, modules, and sub-modules of the computing device 4-10 presented thus far will be described in greater detail with respect to the processes and operations to be described herein. Note that the subjective user state data 4-60 may be in a variety of forms including, for example, text messages (e.g., blog entries, microblog entries, instant messages, text email messages, and so forth), audio messages, and/or images (e.g., an image capturing user's facial expression or gestures).

FIG. 4-3 illustrates an operational flow 4-300 representing example operations related to, among other things, solicitation and acquisition of subjective user state data 4-60 in response to acquisition of objective occurrence data 4-70* in accordance with various embodiments. In some embodiments, the operational flow 4-300 may be executed by, for example, the computing device 4-10 of FIG. 4-1b.

In FIG. 4-3 and in the following figures that include various examples of operational flows, discussions and explanations may be provided with respect to the above-described exemplary environment of FIGS. 4-1a and 4-1b, and/or with respect to other examples (e.g., as provided in FIGS. 4-2a to 4-20 and contexts. However, it should be understood that the operational flows may be executed in a number of other environments and contexts, and/or in modified versions of FIGS. 4-1a, 4-1b, and 4-2a to 4-2f. Also, although the various operational flows are presented in the sequence(s) illustrated, it should be understood that the various operations may be performed in other orders than those which are illustrated, or may be performed concurrently.

Further, in FIG. 4-3 and in following figures, various operations may be depicted in a box-within-a-box manner. Such depictions may indicate that an operation in an internal box may comprise an optional example embodiment of the operational step illustrated in one or more external boxes. However, it should be understood that internal box operations may be viewed as independent operations separate from any associated external boxes and may be performed in any sequence with respect to all other illustrated operations, or may be performed concurrently.

In any event, after a start operation, the operational flow 4-300 may move to an objective occurrence data acquisition operation 4-302 for acquiring objective occurrence data including data indicating occurrence of at least one objective occurrence. For instance, the objective occurrence data acquisition module 4-102 of the computing device 4-10 acquiring (e.g., receiving via network interface 4-120 or via user interface 4-122) objective occurrence data 4-70* including data indicating occurrence of at least one objective occurrence (e.g., an activity performed by a user 4-20*, an activity performed by another user (not depicted), a physical characteristic of the user 4-20*, an external event, and so forth).

Operational flow 4-300 may also include a subjective user state data solicitation operation 4-304 for soliciting, in response to the acquisition of the objective occurrence data, subjective user state data including data indicating occurrence of at least one subjective user state associated with a user. For instance, the subjective user state data solicitation module 4-103 of the computing device 4-10 soliciting (e.g., requesting from the user 4-20*, from the mobile device 4-30, or from a network server), in response to the acquisition of the objective occurrence data 4-70*, subjective user state data 4-60 including data indicating occurrence of at least one subjective user state 4-60a (e.g., a subjective mental state, a subjective physical state, or a subjective overall state) associated with a user 4-20*.

Note that the solicitation of the subjective user state data 4-60, as described above, may or may not be in reference to solicitation of particular data that indicates occurrence of a particular or particular type of subjective user state. That is, in some embodiments, the solicitation of the subjective user state data 4-60 may be in reference to solicitation for subjective user state data 4-60 including data indicating occurrence of any subjective user state, while in other embodiments, the solicitation of the subjective user state data 4-60 may involve solicitation for subjective user state data 4-60 including data indicating occurrence of a particular or particular type of subjective user state.

The term “soliciting” as described above may be in reference to direct or indirect solicitation of (e.g., requesting to be provided with, requesting to access, or other methods of being provided with, or being allowed access) subjective user state data 4-60 from one or more sources. The sources may be the user 4-20* him or herself, a mobile device 4-30, or one or more network servers (not depicted), which may have already been provided with such subjective user state data 4-60. For example, if the computing device 4-10 is a server, then the computing device 4-10 may indirectly solicit the objective occurrence data 4-70* from a user 4-20a by transmitting the solicitation (e.g., a request or inquiry) to the mobile device 4-30, which may then actually solicit the subjective user state data 4-60 from the user 4-20a. Alternatively, such subjective user state data 4-60 may have already been provided to the mobile device 4-30, in which case the mobile device 4-30 merely provides for or allows access to such data. In still other alternative implementations, such subjective user state data 4-60 may have been previously stored in a network server (not depicted), and such a network server may be solicited for the subjective user state data 4-60. In yet other implementations in which the computing device 4-10 is a local device such as a handheld device to be used directly by a user 4-20b, the computing device 4-10 may directly solicit the subjective user state data 4-60 from the user 4-20b.

Operational flow 4-300 may further include subjective user state data acquisition operation 4-306 for acquiring the subjective user state data. For instance, the subjective user state data acquisition module 4-104 of the computing device 4-10 acquiring (e.g., receiving via user interface 4-122 or via the network interface 4-120) the subjective user state data 4-60.

Finally, operational flow 4-300 may include a correlation operation 4-308 for correlating the subjective user state data with the objective occurrence data. For instance, the correlation module 4-106 of the computing device 4-10 correlating the subjective user state data 4-60 with the objective occurrence data 4-70* by determining, for example, at least one sequential pattern (e.g., time sequential pattern) associated with the occurrence of the at least one subjective user state (e.g., user feeling “tired”) and the occurrence of the at least one objective occurrence (e.g., elevated blood sugar level).

In various implementations, the objective occurrence data acquisition operation 4-302 of FIG. 4-3 may include one or more additional operations as illustrated in FIGS. 4-4a, 4-4b, and 4-4c. For example, in some implementations the objective occurrence data acquisition operation 4-302 may include a reception operation 4-402 for receiving the objective occurrence data as depicted in FIG. 4-4a. For instance, the objective occurrence data reception module 4-202 (see FIG. 4-2a) of the computing device 4-10 receiving (e.g., via network interface 4-120 or via the user interface 4-122) the objective occurrence data 4-70*.

The reception operation 4-402 in turn may further include one or more additional operations. For example, in some implementations, the reception operation 4-402 may include an operation 4-404 for receiving the objective occurrence data from at least one of a wireless network or a wired network as depicted in FIG. 4-4a. For instance, the network interface data reception module 4-206 (see FIG. 4-2a) of the computing device 4-10 receiving the objective occurrence data 4-70* from a wireless and/or wired network 4-40 via a network interface 4-120 (e.g., network interface card or “NIC”).

In some implementations, the reception operation 4-402 may include an operation 4-406 for receiving the objective occurrence data via one or more blog entries as depicted in FIG. 4-4a. For instance, the objective occurrence data reception module 4-202 of the computing device 4-10 receiving (e.g., through a network interface 4-120 or through a user interface 4-122) the objective occurrence data 4-70a or 4-70c via one or more blog entries (e.g., microblog entries).

In some implementations, the reception operation 4-402 may include an operation 4-408 for receiving the objective occurrence data via one or more status reports as depicted in FIG. 4-4a. For instance, the objective occurrence data reception module 4-202 of the computing device 4-10 receiving (e.g., through the network interface 4-120 or through the user interface 4-122) the objective occurrence data 4-70a or 4-70c via one or more status reports (e.g., social networking site status reports).

In some implementations, the reception operation 4-402 may include an operation 4-410 for receiving the objective occurrence data from one or more third party sources as depicted in FIG. 4-4a. For instance, the objective occurrence data reception module 4-202 of the computing device 4-10 receiving (e.g., through the network interface 4-120) the objective occurrence data 4-70a from one or more third party sources (e.g., other users, healthcare entities such as medical or dental clinics, hospitals, athletic gyms, content providers, and so forth).

In some implementations, the reception operation 4-402 may include an operation 4-412 for receiving the objective occurrence data from one or more sensors configured to sense one or more objective occurrences as depicted in FIG. 4-4a. For instance, the objective occurrence data reception module 4-202 of the computing device 4-10 receiving (e.g., through the network interface 4-120) the objective occurrence data 4-70b from one or more sensors 4-35 (e.g., one or more physiological sensors such as glucometers and blood pressure devices, pedometer, GPS, and so forth) configured to sense one or more objective occurrences (e.g., one or more physiological characteristics of user 4-20a, one or more physical activities of the user 4-20a, and/or one or more locations of user 4-20a).

In some implementations, the reception operation 4-402 may include an operation 4-414 for receiving the objective occurrence data from the user as depicted in FIG. 4-4a. For instance, the objective occurrence data reception module 4-202 of the computing device 4-10 receiving (e.g., through the network interface 4-120 or through the user interface 4-122) the objective occurrence data 4-70c from the user 4-20*.

The objective occurrence data acquisition operation 4-302 of FIG. 4-3 may, in various implementations, include an operation 4-416 for acquiring a time stamp associated with occurrence of the at least one objective occurrence as depicted in FIG. 4-4a. For instance, the time stamp acquisition module 4-210 of the computing device 4-10 acquiring (e.g., via the network interface 4-120, via the user interface 4-122 as provided by the user 4-20*, or by self or automatically generating) a time stamp associated with occurrence of the at least one objective occurrence (e.g., a physical characteristic of the user 4-20*, one or more locations associated with the user 4-20*, an activity executed by the user 4-20* or by others, an external event such as local weather, or some other objectively observable occurrence).

In some implementations, the objective occurrence data acquisition operation 4-302 may include an operation 4-418 for acquiring an indication of a time interval associated with occurrence of the at least one objective occurrence as depicted in FIG. 4-4a. For instance, the time interval acquisition module 4-212 of the computing device 4-10 acquiring (e.g., via the network interface 4-120, via the user interface 4-122 as provided by the user 4-20*, or by self or automatically generating) an indication of a time interval associated with occurrence of the at least one objective occurrence.

In some implementations, the objective occurrence data acquisition operation 4-302 may include an operation 4-420 for acquiring an indication of a temporal relationship between occurrence of the at least one objective occurrence and occurrence of at least one subjective user state as depicted in FIG. 4-4b. For instance, the temporal relationship acquisition module 4-214 of the computing device 4-10 acquiring (e.g., via the network interface 4-120, via the user interface 4-122 as provided by the user 4-20*, or by automatically generating) an indication of at least a temporal relationship (e.g., before, after, or at least partially concurrently) between occurrence of the at least one objective occurrence (e.g., staying up late) and occurrence of the at least one subjective user state (e.g., headache).

In some implementations, the objective occurrence data acquisition operation 4-302 may include an operation 4-422 for acquiring data indicating the at least one objective occurrence and one or more attributes associated with the at least one objective occurrence as depicted in FIG. 4-4b. For instance, the objective occurrence data reception module 4-202 of the computing device 4-10 acquiring data indicating the at least one objective occurrence (e.g., ingestion of a medicine or food item) and one or more attributes (e.g., quality, quantity, brand, and/or source of the medicine or food item ingested) associated with the at least one objective occurrence.

In some implementations, the objective occurrence data acquisition operation 4-302 may include an operation 4-424 for acquiring data indicating at least one objective occurrence of an ingestion by the user of a medicine as depicted in FIG. 4-4b. For instance, the objective occurrence data acquisition module 4-102 of the computing device 4-10 acquiring (e.g., via the network interface 4-120 or via the user interface 4-122) data indicating at least one objective occurrence of an ingestion by the user 4-20* of a medicine (e.g., a dosage of a beta blocker).

In some implementations, the objective occurrence data acquisition operation 4-302 may include an operation 4-426 for acquiring data indicating at least one objective occurrence of an ingestion by the user of a food item as depicted in FIG. 4-4b. For instance, the objective occurrence data acquisition module 4-102 of the computing device 4-10 acquiring (e.g., via the network interface 4-120 or via the user interface 4-122) data indicating at least one objective occurrence of an ingestion by the user 4-20* of a food item (e.g., an orange).

In some implementations, the objective occurrence data acquisition operation 4-302 may include an operation 4-428 for acquiring data indicating at least one objective occurrence of an ingestion by the user of a nutraceutical as depicted in FIG. 4-4b. For instance, the objective occurrence data acquisition module 4-102 of the computing device 4-10 acquiring (e.g., via the network interface 4-120 or via the user interface 4-122) data indicating at least one objective occurrence of an ingestion by the user 4-20* of a nutraceutical (e.g. broccoli).

In some implementations, the objective occurrence data acquisition operation 4-302 may include an operation 4-430 for acquiring data indicating at least one objective occurrence of an exercise routine executed by the user as depicted in FIG. 4-4b. For instance, the objective occurrence data acquisition module 4-102 of the computing device 4-10 acquiring (e.g., via the network interface 4-120 or via the user interface 4-122) data indicating at least one objective occurrence of an exercise routine (e.g., working out on an exercise machine such as a treadmill) executed by the user 4-20*.

In some implementations, the objective occurrence data acquisition operation 4-302 may include an operation 4-432 for acquiring data indicating at least one objective occurrence of a social activity executed by the user as depicted in FIG. 4-4c. For instance, the objective occurrence data acquisition module 4-102 of the computing device 4-10 acquiring (e.g., via the network interface 4-120 or via the user interface 4-122) data indicating at least one objective occurrence of a social activity (e.g., hiking or skiing with friends, dates, dinners, and so forth) executed by the user 4-20*.

In some implementations, the objective occurrence data acquisition operation 4-302 may include an operation 4-434 for acquiring data indicating at least one objective occurrence of an activity performed by a third party as depicted in FIG. 4-4c. For instance, the objective occurrence data acquisition module 4-102 of the computing device 4-10 acquiring (e.g., via the network interface 4-120 or via the user interface 4-122) data indicating at least one objective occurrence of an activity (e.g., boss on a vacation) performed by a third party 4-50.

In some implementations, the objective occurrence data acquisition operation 4-302 may include an operation 4-436 for acquiring data indicating at least one objective occurrence of a physical characteristic of the user as depicted in FIG. 4-4c. For instance, the objective occurrence data acquisition module 4-102 of the computing device 4-10 acquiring (e.g., via the network interface 4-120 or via the user interface 4-122) data indicating at least one objective occurrence of a physical characteristic (e.g., a blood sugar level) of the user 4-20*. Note that a physical characteristic such as a blood sugar level could be determined using a device such as a glucometer and then reported by the user 4-20*, by a third party 4-50, or by the device (e.g., glucometer) itself.

In some implementations, the objective occurrence data acquisition operation 4-302 may include an operation 4-438 for acquiring data indicating at least one objective occurrence of a resting, a learning or a recreational activity by the user as depicted in FIG. 4-4c. For instance, the objective occurrence data acquisition module 4-102 of the computing device 4-10 acquiring (e.g., via the network interface 4-120 or via the user interface 4-122) data indicating at least one objective occurrence of a resting (e.g., sleeping), a learning (e.g., reading), or a recreational activity (e.g., a round of golf) by the user 4-20*.

In some implementations, the objective occurrence data acquisition operation 4-302 may include an operation 4-440 for acquiring data indicating at least one objective occurrence of an external event as depicted in FIG. 4-4c. For instance, the objective occurrence data acquisition module 4-102 of the computing device 4-10 acquiring (e.g., via the network interface 4-120 or via the user interface 4-122) data indicating at least one objective occurrence of an external event (e.g., rain storm). Examples of external events include, for example, the weather, performance of the stock market, air quality level, and/or any other events that may or may not be of interest to a user 4-20*.

In some implementations, the objective occurrence data acquisition operation 4-302 may include an operation 4-442 for acquiring data indicating at least one objective occurrence related to a location of the user as depicted in FIG. 4-4c. For instance, the objective occurrence data acquisition module 4-102 of the computing device 4-10 acquiring (e.g., via the network interface 4-120 or via the user interface 4-122) data indicating at least one objective occurrence related to a location (e.g., work office at a point or interval in time) of the user 4-20*. In some instances, such data may be provided by the user 4-20* via the user interface 4-122 (e.g., in the case where the computing device 4-10 is a local device) or via the mobile device 4-30 (e.g., in the case where the computing device 4-10 is a network server). Alternatively, such data may be provided directly by a sensor device 4-35 such as a GPS device, or by a third party 4-50.

Referring back to FIG. 4-3, the subjective user state data solicitation operation 4-304 in various embodiments may include one or more additional operations as illustrated in FIGS. 4-5a to 4-5d. For example, in some implementations, the subjective user state data solicitation operation 4-304 may include an operation 4-500 for requesting for subjective user state data including the data indicating occurrence of at least one subjective user state associated with a user as depicted in FIG. 4-5a. For instance, the requesting module 4-217 (see FIG. 4-2b) of the computing device 4-10 requesting (e.g., transmitting a request via a network interface 4-120 or indicating a request via a user interface 4-122) for subjective user state data 4-60 including the data indicating occurrence of at least one subjective user state 4-60a (e.g., subjective mental state, subjective physical state, or subjective overall state) associated with a user 4-20*.

In some implementations, operation 4-500 may further include an operation 4-502 for requesting to be provided with the data indicating occurrence of at least one subjective user state associated with a user as depicted in FIG. 4-5a. For instance, the requesting module 4-217 (see FIG. 4-2b) of the computing device 4-10 requesting (e.g., transmitting a request via a network interface 4-120 or indicating a request via a user interface 4-122) to be provided with the data indicating occurrence of at least one subjective user state 4-60a associated with a user 4-20*. In some instances, this may involve asking a user 4-20*, a mobile device 4-30, or a third party source such as a network server (not depicted) to provide the data indicating occurrence of at least one subjective user state 4-60a associated with the user 4-20*.

In some implementations, operation 4-500 may include an operation 4-504 for requesting to have access to the data indicating occurrence of at least one subjective user state associated with a user as depicted in FIG. 4-5a. For instance, the requesting module 4-217 (see FIG. 4-2b) of the computing device 4-10 requesting (e.g., asking a mobile device 4-30 and/or a third party source such as a network server) to have access to the data indicating occurrence of at least one subjective user state 4-60a associated with a user 4-20a.

In some implementations, the subjective user state data solicitation operation 4-304 may include an operation 4-506 for configuring to obtain the data indicating occurrence of at least one subjective user state associated with a user as depicted in FIG. 4-5a. For instance, the configuration module 4-218 of the computing device 4-10 configuring (e.g., a mobile device 4-30 or a network server) to obtain the data indicating occurrence of at least one subjective user state 4-60a (e.g., subjective mental state, subjective physical state, or subjective overall state) associated with a user 4-20a.

In some implementations, the subjective user state data solicitation operation 4-304 may include an operation 4-508 for directing or instructing to obtain the data indicating occurrence of at least one subjective user state associated with a user as depicted in FIG. 4-5a. For instance, the directing/instructing module 4-219 directing or instructing (e.g., directing or instructing a mobile device 4-30 or a network server) to obtain the data indicating occurrence of at least one subjective user state 4-60a (e.g., subjective mental state, subjective physical state, or subjective overall state) associated with a user 4-20a. That is, a mobile device 4-30 or a network server, for example, may be instructed or directed to provide (e.g., allow access or to supply or transmit) the data indicating occurrence of the at least one subjective user state 4-60a associated with the user 4-20a.

In some implementations, the subjective user state data solicitation operation 4-304 may include an operation 4-510 for soliciting from the user the data indicating occurrence of at least one subjective user state associated with the user as depicted in FIG. 4-5a. For instance, the subjective user state data solicitation module 4-103 of the computing device 4-10 soliciting (e.g., via user interface 4-122 or via network interface 4-120) from the user 4-20* the data indicating occurrence of at least one subjective user state 4-60a (e.g., subjective mental state, subjective physical state, or subjective overall state) associated with the user 4-20*.

Operation 4-510, in turn, may further include an operation 4-512 for soliciting the data indicating occurrence of at least one subjective user state associated with the user via a user interface as depicted in FIG. 4-5a. For instance, the user interface solicitation module 4-216 of the computing device 4-10 soliciting (e.g., audibly or visually requesting through an audio system or a display system) the data indicating occurrence of at least one subjective user state 4-60a (e.g., subjective mental state, subjective physical state, or subjective overall state) associated with the user 4-20b via a user interface 4-122.

In various implementations, operation 4-512 may include an operation 4-514 for indicating a request for the data indicating occurrence of at least one subjective user state associated with the user through at least one of a display monitor or a touchscreen as depicted in FIG. 4-5a. For instance, the indication module 4-221 of the computing device 4-10 visually indicating a request for the data indicating occurrence of at least one subjective user state 4-60a (e.g., subjective mental state, subjective physical state, or subjective overall state) associated with the user 4-20b through at least one of a display monitor or a touchscreen.

In some implementations, operation 4-512 may include an operation 4-516 for indicating a request for the data indicating occurrence of at least one subjective user state associated with the user through at least an audio system as depicted in FIG. 4-5a. For instance, the indication module 4-221 of the computing device 4-10 audibly indicating a request for the data indicating occurrence of at least one subjective user state 4-60a (e.g., subjective mental state, subjective physical state, or subjective overall state) associated with the user 4-20b through at least an audio system.

In various implementations, operation 4-510 of FIG. 4-5a may also include an operation 4-518 for soliciting the data indicating occurrence of at least one subjective user state associated with the user via a network interface as depicted in FIG. 4-5b. For instance, the network interface solicitation module 4-215 soliciting (e.g., transmitting a request for supplying or a request to access) the data indicating occurrence of at least one subjective user state 4-60a (e.g., subjective mental state, subjective physical state, or subjective overall state) associated with the user 4-20a via a network interface 4-120.

Operation 4-518, in some implementations, may further include an operation 4-520 for transmitting to the user a request for the data indicating occurrence of at least one subjective user state associated with the user as depicted in FIG. 4-5b. For instance, the transmission module 4-220 of the computing device 4-10 transmitting to the user 4-20a (e.g., transmitting to a client device such as mobile device 4-30) a request for the data indicating occurrence of at least one subjective user state 4-60a (e.g., subjective mental state, subjective physical state, or subjective overall state) associated with the user 4-20a.

In some implementations, operation 4-510 may include an operation 4-522 for requesting the user to select a subjective user state from a plurality of indicated alternative subjective user states as depicted in FIG. 4-5b. For instance, the requesting module 4-217 of the computing device 4-10 audibly or visually requesting the user 4-20* to select a subjective user state (e.g., feeing hot) from a plurality of indicated alternative subjective user states (e.g., feeling hot, feeling cold, feeling extremely cold, feeling extremely hot, feeling good, feeling bad, feeling ill, having a headache, having a stomach ache, and so forth). In some cases, this may be accomplished by, for example, displaying via a display monitor or a touchscreen a list of different subjective user states that the user 4-20* can select from.

Operation 4-522, in turn, may further include an operation 4-524 for requesting the user to select a subjective user state from a plurality of indicated alternative contrasting subjective user states as depicted in FIG. 4-5b. For instance, the requesting module 4-217 of the computing device 4-10 audibly or visually requesting the user 4-20* to select a subjective user state (e.g., feeling very good) from a plurality of indicated alternative contrasting subjective user states (e.g., feeling extremely happy, feeling very happy, feeling happy, feeling slightly happy, feeling indifferent, feeling sad, feeling very sad, and so forth).

In various implementations, operation 4-510 may include an operation 4-526 for requesting the user to confirm occurrence of a subjective user state as depicted in FIG. 4-5b. For instance, the requesting module 4-217 of the computing device 4-10 audibly or visually requesting the user 4-20* to confirm occurrence of a subjective user state (e.g., is user feeling nauseous?). In some implementations, such an operation may include providing other additional information to the user 4-20* such as “does the user feel nauseous after drinking the beer this morning?” Note that in this example, the consumption of the beer would be an objective occurrence that may have been previously reported by the user 4-20*.

In some implementations, operation 4-510 may include an operation 4-528 for requesting the user to provide an indication of occurrence of the at least one subjective user state with respect to occurrence of the at least one objective occurrence as depicted in FIG. 4-5b. For instance, the requesting module 4-217 of the computing device 4-10 audibly or visually requesting the user 4-20* to provide an indication of occurrence of the at least one subjective user state with respect to occurrence of the at least one objective occurrence. As an illustration, the user 4-20b may be asked through the user interface 4-122 (e.g., an audio system or a visual system such as a display monitor) how the user 4-20b felt, for example, after taking a walk (e.g., an objective occurrence that may have been reported by the user 4-20b).

In some implementations, operation 4-510 may include an operation 4-530 for requesting the user to provide an indication of a time or temporal element associated with occurrence of the at least one subjective user state as depicted in FIG. 4-5c. For instance, the requesting module 4-217 of the computing device 4-10 audibly or visually requesting the user 4-20* to provide an indication of a time or temporal element (e.g., morning, afternoon, evening, before lunch, after lunch, before midnight, after midnight, etc.) associated with occurrence of the at least one subjective user state (e.g., feeling gloomy). For example, a user 4-20* being asked through the user interface 4-122 or through the mobile device 4-30 what part of the day did the user 4-20* feel gloomy?

Operation 4-530 may, in turn, include one or more additional operations. For example, in some implementations operation 4-530 may include an operation 4-532 for requesting the user to provide an indication of a point in time associated with the occurrence of the at least one subjective user state as depicted in FIG. 4-5c. For instance, the requesting module 4-217 of the computing device 4-10 requesting the user 4-20* to provide an indication of a point in time (e.g., 3 PM) associated with the occurrence of the at least one subjective user state (e.g., user feeling tired).

In some implementations, operation 4-530 may include an operation 4-534 for requesting the user to provide an indication of a time interval associated with the occurrence of the at least one subjective user state as depicted in FIG. 4-5c. For instance, the requesting module 4-217 of the computing device 4-10 requesting the user 4-20* to provide an indication of a time interval associated with the occurrence of the at least one subjective user state (e.g., headache). For example, asking a user 4-20b, via the user interface 4-122, from what time to what time did the user 4-20* have a headache?

In some implementations, operation 4-530 may include an operation 4-536 for requesting the user to provide an indication of a temporal relationship between occurrence of the at least one subjective user state and occurrence of at least one objective occurrence as depicted in FIG. 4-5c. For instance, the requesting module 4-217 of the computing device 4-10 requesting the user 4-20* to provide an indication of a temporal relationship between occurrence of the at least one subjective user state and occurrence of at least one objective occurrence (e.g., asking a user 4-20* if the user 4-20* felt sick during, before, or after eating at the user's favorite Latin restaurant).

In various implementations, the subjective user state data solicitation operation 4-304 of FIG. 4-3 may include an operation 4-538 for soliciting data indicating occurrence of at least one subjective mental state associated with the user as depicted in FIG. 4-5c. For instance, the subjective user state data solicitation module 4-103 of the computing device 4-10 soliciting (e.g., via the user interface 4-122 or via the network interface 4-120) data indicating occurrence of at least one subjective mental state (e.g., happiness, sadness, pessimism, optimism, pain, alertness, mental fatigue, fatigue, love, desire, and so forth) associated with the user 4-20*.

In some implementations, the subjective user state data solicitation operation 4-304 may include an operation 4-540 for soliciting data indicating occurrence of at least one subjective physical state associated with the user as depicted in FIG. 4-5c. For instance, the subjective user state data solicitation module 4-103 of the computing device 4-10 soliciting (e.g., via the user interface 4-122 or via the network interface 4-120) data indicating occurrence of at least one subjective physical state (e.g., presence or absence of an upset stomach, a level of physical fatigue, and so forth) associated with the user 4-20*.

In some implementations, the subjective user state data solicitation operation 4-304 may include an operation 4-542 for soliciting data indicating occurrence of at least one subjective overall state associated with the user as depicted in FIG. 4-5c. For instance, the subjective user state data solicitation module 4-103 of the computing device 4-10 soliciting (e.g., via the user interface 4-122 or via the network interface 4-120) data indicating occurrence of at least one subjective overall state (e.g., user is good, bad, rested, and so forth) associated with the user 4-20*.

In some implementations, the subjective user state data solicitation operation 4-304 may include an operation 4-544 for soliciting data indicating occurrence of at least one subjective user state during a specified point in time as depicted in FIG. 4-5c. For instance, the subjective user state data solicitation module 4-103 of the computing device 4-10 soliciting (e.g., via the user interface 4-122 or via the network interface 4-120) data indicating occurrence of at least one subjective user state 4-60a (e.g., user wellness) that occurred during a specified point in time. For example, asking a user 4-20* via the user interface 4-122 or via the mobile device 4-30 how the user 4-20* felt at 6 PM.

In some implementations, the subjective user state data solicitation operation 4-304 may include an operation 4-546 for soliciting data indicating occurrence of at least one subjective user state during a specified time interval as depicted in FIG. 4-5c. For instance, the subjective user state data solicitation module 4-103 of the computing device 4-10 soliciting (e.g., via the user interface 4-122 or via the network interface 4-120) data indicating occurrence of at least one subjective user state 4-60a that occurred during a specified time interval. For example, asking a user 4-20b, via the user interface 4-122, how the user 4-20b felt between 6 PM and 8 PM.

In some implementations, the subjective user state data solicitation operation 4-304 may include an operation 4-548 for soliciting data indicating occurrence of the at least one subjective user state in response to the acquisition of the objective occurrence data and based on historical data as depicted in FIG. 4-5d. For instance, the subjective user state data solicitation module 4-103 of the computing device 4-10 being prompted to solicit (e.g., via the user interface 4-122 or via the network interface 4-120) data indicating occurrence of the at least one subjective user state 4-60a in response to the acquisition of the objective occurrence data 4-70* and based on referencing of historical data 4-72.

For example, suppose the historical data 4-72 indicates that the last time the user 4-20* ate a chocolate sundae, the user 4-20* had a stomach ache. Suppose further that the user 4-20* again reports that the user 4-20* ate another chocolate sundae (e.g., objective occurrence) the next day but forgets to indicate the subjective user state of the user 4-20* after eating the chocolate sundae. Then, upon the reporting of the objective occurrence (e.g., eating a chocolate sundae), and based on historical data 4-72 (e.g., the previous reports of eating a chocolate sundae and having a stomach ache), the user 4-20* may be asked via the user interface 4-122 or via the mobile device 4-30 how the user 4-20* feels or whether the user 4-20* had a stomach ache after consuming the chocolate sundae.

Alternatively, a solicitation from the mobile device 4-30 or from a network server (not depicted) for data that indicates the subjective user state of the user 4-20a around the time of the consumption of the second chocolate sundae may be prompted based on the reporting of the consumption of the second chocolate sundae and based on historical data 4-72 without soliciting such data from the user 4-20a. That is, in some cases, such data may have already been received and/or recorded by the mobile device 4-30 or by the network server. In which case, there is no need to solicit the data from the user 4-20a and instead, the relevant data may only need to be accessed or be prompted to be released.

In various implementations, operation 4-548 may include one or more additional operations. For example, in some implementations, operation 4-548 may include an operation 4-550 for soliciting data indicating occurrence of the at least one subjective user state based, at least in part, on one or more historical sequential patterns as depicted in FIG. 4-5d. For instance, the subjective user state data solicitation module 4-103 of the computing device 4-10 being prompted to solicit (e.g., via the user interface 4-122 or via the network interface 4-120) data indicating occurrence of the at least one subjective user state 4-60a based, at least in part, on one or more historical sequential patterns (e.g., historical sequential patterns associated with the user 4-20*, derived from general population, or from a group of users).

In some implementations, operation 4-548 may include an operation 4-552 for soliciting data indicating occurrence of the at least one subjective user state based, at least in part, on medical data associated with the user as depicted in FIG. 4-5d. For instance, the subjective user state data solicitation module 4-103 of the computing device 4-10 being prompted to solicit (e.g., via the user interface 4-122 or via the network interface 4-120) data indicating occurrence of the at least one subjective user state 4-60a based, at least in part, on medical data (e.g., genetic, metabolome, or proteome data of the user 4-20*) associated with the user 4-20*.

In some implementations, operation 4-548 may include an operation 4-554 for soliciting data indicating occurrence of the at least one subjective user state based, at least in part, on the historical data indicating a link between a subjective user state type and an objective occurrence type as depicted in FIG. 4-5d. For instance, the subjective user state data solicitation module 4-103 of the computing device 4-10 being prompted to solicit (e.g., via the user interface 4-122 or via the network interface 4-120) data indicating occurrence of the at least one subjective user state 4-60a (e.g., feeling gloomy) based, at least in part, on the historical data 4-72 indicating a link between a subjective user state type and an objective occurrence type (e.g., link between moods of people and weather).

In some implementations, operation 4-548 may include an operation 4-556 for soliciting data indicating occurrence of the at least one subjective user state, the soliciting prompted, at least in part, by the historical data as depicted in FIG. 4-5d. For instance, the subjective user state data solicitation module 4-103 of the computing device 4-10 being prompted to solicit (e.g., via the user interface 4-122 or via the network interface 4-120) data indicating occurrence of the at least one subjective user state (e.g., feeling gloomy), the soliciting prompted, at least in part, by the historical data 4-72 (e.g., historical data 4-72 that indicates that the user 4-20* or people in the general population tend to be gloomy when there is overcast weather).

In some implementations, operation 4-548 may include an operation 4-558 for soliciting data indicating occurrence of a particular or a particular type of subjective user state based on the historical data as depicted in FIG. 4-5d. For instance, the subjective user state data solicitation module 4-103 of the computing device 4-10 being prompted to solicit (e.g., via the user interface 4-122 or via the network interface 4-120) data indicating occurrence of a particular or a particular type of subjective user state (e.g., requesting for an indication of a subjective physical state of the user 4-20* such as requesting for an indication as to whether the user 4-20* has a stomach condition or a stomach ache) based on the historical data 4-72 (e.g., historical data 4-72 that links stomach aches to eating chocolate sundaes).

In some implementations, the subjective user state data solicitation operation 4-304 may include an operation 4-560 for soliciting data indicating one or more attributes associated with the at least one subjective user state as depicted in FIG. 4-5d. For instance, the subjective user state data solicitation module 4-103 of the computing device 4-10 being prompted to solicit (e.g., via the user interface 4-122 or via the network interface 4-120) data indicating one or more attributes associated with the at least one subjective user state (e.g., intensity or length of pain).

In various embodiments, the subjective user state data acquisition operation 4-306 of FIG. 4-3 may include one or more additional operations as illustrated in FIGS. 4-6a to 4-6c. For example, in some implementations, the subjective user state data acquisition operation 4-306 may include an operation 4-602 for receiving the subjective user state data via a user interface as depicted in FIG. 4-6a. For instance, the subjective user state data user interface reception module 4-226 (see FIG. 4-2c) of the computing device 4-10 receiving the subjective user state data 4-60 via a user interface 4-122 (e.g., a key pad, a touchscreen, a mouse, an audio system including a microphone, an image capturing system such as a digital or video camera, or other user interface devices).

In some embodiments, the subjective user state data acquisition operation 4-306 may include an operation 4-604 for receiving the subjective user state data via a network interface as depicted in FIG. 4-6a. For instance, the subjective user state data network interface reception module 4-227 of the computing device 4-10 receiving the subjective user state data 4-60 (e.g., in the form of text data, audio data, or image data) via a network interface 4-120 (e.g., network interface card or “NIC”).

Operation 4-604 may, in turn, include one or more additional operations in various alternative implementations. For example, in some implementations, operation 4-604 may include an operation 4-606 for receiving data indicating the at least one subjective user state via an electronic message generated by the user as depicted in FIG. 4-6a. For instance, the subjective user state data network interface reception module 4-227 of the computing device 4-10 receiving (e.g., via network interface 4-120) data indicating the at least one subjective user state 4-60a via an electronic message (e.g., email, instant message, text message, and so forth) generated, at least in part, by the user 4-20a.

In some implementations, operation 4-604 may include an operation 4-608 for receiving data indicating the at least one subjective user state via a blog entry generated by the user as depicted in FIG. 4-6a. For instance, the subjective user state data network interface reception module 4-227 of the computing device 4-10 receiving (e.g., via network interface 4-120) data indicating the at least one subjective user state via one or more blog entries (e.g., microblog entry) generated, at least in part, by the user 4-20a.

In some implementations, operation 4-604 may include an operation 4-610 for receiving data indicating the at least one subjective user state via a status report generated by the user as depicted in FIG. 4-6a. For instance, the subjective user state data network interface reception module 4-227 of the computing device 4-10 receiving (e.g., via network interface 4-120) data indicating the at least one subjective user state via one or more status reports (e.g., social networking status report) generated, at least in part, by the user 4-20a.

In some embodiments, the subjective user state data acquisition operation 4-306 may include an operation 4-612 for receiving subjective user state data including data indicating at least one subjective user state specified by a selection made by the user, the selection being a selection of a subjective user state from a plurality of indicated alternative subjective user states as depicted in FIG. 4-6a. For instance, the reception module 4-224 (see FIG. 4-2c) of the computing device 4-10 receiving subjective user state data 4-60 including data indicating at least one subjective user state 4-60a specified by a selection made by the user 4-20*, the selection being a selection of a subjective user state from a plurality of indicated alternative subjective user states (e.g., as indicated by the user interface 4-122 or by the mobile device 4-30). For example, user 4-20b may be allowed to select a subjective user state from a list of alternative subjective user states (e.g., feeling well, feeling sore, feeling sad, having a headache, and so forth) displayed by a display monitor (e.g., user interface 4-122).

In certain implementations, operation 4-612 may further include an operation 4-614 for receiving subjective user state data including data indicating at least one subjective user state specified by a selection made by the user, the selection being a selection of a subjective user state from at least two indicated alternative contrasting subjective user states as depicted in FIG. 4-6a. For instance, the reception module 4-224 (see FIG. 4-2c) of the computing device 4-10 receiving subjective user state data 4-60 including data indicating at least one subjective user state 4-60a specified by a selection made by the user 4-20*, the selection being a selection of a subjective user state from at least two indicated alternative contrasting subjective user states (e.g., feeling hot, feeling warm, feeling cool, and so forth).

In some embodiments, the subjective user state data acquisition operation 4-306 may include an operation 4-616 for acquiring data indicating occurrence of at least one subjective mental state of the user as depicted in FIG. 4-6b. For instance, the subjective user state data acquisition module 4-104 of the computing device 4-10 acquiring (e.g., via the user interface 4-122 or via the network interface 4-120) data indicating occurrence of at least one subjective mental state of the user 4-20*. Examples of subjective mental states includes, for example, happiness, sadness, mental fatigue, certain types of pain, alertness, love, envy, disgust or repulsiveness, and so forth.

In some embodiments, the subjective user state data acquisition operation 4-306 may include an operation 4-618 for acquiring data indicating occurrence of at least one subjective physical state of the user as depicted in FIG. 4-6b. For instance, the subjective user state data acquisition module 4-104 of the computing device 4-10 acquiring (e.g., via the user interface 4-122 or via the network interface 4-120) data indicating occurrence of at least one subjective physical state of the user 4-20*. Examples of subjective physical states include upset stomach, pain related to different parts of the body, condition of user vision (e.g., blurry vision), sensitivity of teeth, physical fatigue, and so forth.

In some embodiments, the subjective user state data acquisition operation 4-306 may include an operation 4-620 for acquiring data indicating occurrence of at least one subjective overall state of the user as depicted in FIG. 4-6b. For instance, the subjective user state data acquisition module 4-104 of the computing device 4-10 acquiring (e.g., via the user interface 4-122 or via the network interface 4-120) data indicating occurrence of at least one subjective overall state of the user 4-20*. Examples of subjective overall states include, “good,” “bad,” “wellness,” and so forth.

In some embodiments, the subjective user state data acquisition operation 4-306 may include an operation 4-622 for acquiring a time stamp associated with occurrence of at least one subjective user state as depicted in FIG. 4-6b. For instance, the time stamp acquisition module 4-230 of the computing device 4-10 acquiring (e.g., via the network interface 4-120, via the user interface 4-122 as provided by the user 4-20*, or by automatically generating) a time stamp associated with occurrence of at least one subjective user state.

In some embodiments, the subjective user state data acquisition operation 4-306 may include an operation 4-624 for acquiring an indication of a time interval associated with occurrence of at least one subjective user state as depicted in FIG. 4-6b. For instance, the time interval acquisition module 4-231 of the computing device 4-10 acquiring (e.g., via the network interface 4-120, via the user interface 4-122 as provided by the user 4-20*, or by automatically generating) an indication of a time interval (e.g., 3 PM to 5 PM) associated with occurrence of at least one subjective user state (e.g., hunger).

In some embodiments, the subjective user state data acquisition operation 4-306 may include an operation 4-626 for acquiring an indication of a temporal relationship between occurrence of at least one subjective user state and occurrence of at least one objective occurrence as depicted in FIG. 4-6b. For instance, the temporal relationship acquisition module 4-232 of the computing device 4-10 acquiring (e.g., via the network interface 4-120, via the user interface 4-122 as provided by the user 4-20*, or by automatically generating) an indication of a temporal relationship (e.g., before, after, or at least partially concurrently) between occurrence of at least one subjective user state (e.g., alertness) and occurrence of at least one objective occurrence (e.g., exercise).

In some embodiments, the subjective user state data acquisition operation 4-306 may include an operation 4-628 for acquiring the subjective user state data at a server as depicted in FIG. 4-6b. For instance, the subjective user state data acquisition module 4-104 of the computing device 4-10 acquiring (e.g., via the network interface 4-120) the subjective user state data 4-60 when the computing device 4-10 is a network server.

In some embodiments, the subjective user state data acquisition operation 4-306 may include an operation 4-630 for acquiring the subjective user state data at a handheld device as depicted in FIG. 4-6c. For instance, the subjective user state data acquisition module 4-104 of the computing device 4-10 acquiring (e.g., via the user interface 4-122) the subjective user state data 4-60 when the computing device 4-10 is a local computing device such as a handheld device.

In some embodiments, the subjective user state data acquisition operation 4-306 may include an operation 4-632 for acquiring the subjective user state data at a peer-to-peer network component device as depicted in FIG. 4-6c. For instance, the subjective user state data acquisition module 4-104 of the computing device 4-10 acquiring (e.g., via the user interface 4-122 or via the network interface 4-120) the subjective user state data 4-60 when the computing device 4-10 is a peer-to-peer network component device.

In some embodiments, the subjective user state data acquisition operation 4-306 may include an operation 4-634 for acquiring the subjective user state data via a Web 2.0 construct as depicted in FIG. 4-6c. For instance, the subjective user state data acquisition module 4-104 of the computing device 4-10 acquiring (e.g., via the user interface 4-122 or via the network interface 4-120) the subjective user state data 4-60 when the computing device 4-10 is executing a Web 2.0 construct (e.g., Web 2.0 application).

In some embodiments, the subjective user state data acquisition operation 4-306 may include an operation 4-636 for acquiring data indicating at least one subjective user state that occurred at least partially concurrently with an incidence of the at least one objective occurrence as depicted in FIG. 4-6c. For instance, the subjective user state data acquisition module 4-104 of the computing device 4-10 acquiring (e.g., via the user interface 4-122 or via the network interface 4-120) data indicating at least one subjective user state (e.g., happiness) that occurred at least partially concurrently with an incidence of the at least one objective occurrence (e.g., boss going on a vacation).

In some embodiments, the subjective user state data acquisition operation 4-306 may include an operation 4-638 for acquiring data indicating at least one subjective user state that occurred prior to an incidence of the at least one objective occurrence as depicted in FIG. 4-6c. For instance, the subjective user state data acquisition module 4-104 of the computing device 4-10 acquiring (e.g., via the user interface 4-122 or via the network interface 4-120) data indicating at least one subjective user state (e.g., anxiety) that occurred prior to an incidence of the at least one objective occurrence (e.g., exam).

In some embodiments, the subjective user state data acquisition operation 4-306 may include an operation 4-640 for acquiring data indicating at least one subjective user state that occurred subsequent to an incidence of the at least one objective occurrence as depicted in FIG. 4-6c. For instance, the subjective user state data acquisition module 4-104 of the computing device 4-10 acquiring (e.g., via the user interface 4-122 or via the network interface 4-120) data indicating at least one subjective user state (e.g., hangover) that occurred subsequent to an incidence of the at least one objective occurrence (e.g., alcohol consumption by the user 4-20*).

In some embodiments, the subjective user state data acquisition operation 4-306 may include an operation 4-642 for acquiring data indicating at least one subjective user state that occurred within a predefined time period of an incidence of the at least one objective occurrence as depicted in FIG. 4-6c. For instance, the subjective user state data acquisition module 4-104 of the computing device 4-10 acquiring (e.g., via the user interface 4-122 or via the network interface 4-120) data indicating at least one subjective user state (e.g., sore ankle) that occurred within a predefined time period (e.g., one day) of an incidence of the at least one objective occurrence (e.g., user 4-20* playing basketball).

Referring back to FIG. 4-3, the correlation operation 4-308 may include one or more additional operations in various alternative implementations. For example, in some implementations, the correlation operation 4-308 may include an operation 4-702 for correlating the subjective user state data with the objective occurrence data based, at least in part, on a determination of at least one sequential pattern associated with occurrence of the at least one subjective user state and occurrence of the at least one objective occurrence as depicted in FIG. 4-7a. For instance, the correlation module 4-106 of the computing device 4-10 correlating the subjective user state data 4-60 with the objective occurrence data 4-70* based, at least in part, on a determination (e.g., as determined by the sequential pattern determination module 4-236) of at least one sequential pattern associated with occurrence of the at least one subjective user state and occurrence of the at least one objective occurrence.

In various alternative implementations, operation 4-702 may include one or more additional operations. For example, in some implementations, operation 4-702 may include an operation 4-704 for correlating the subjective user state data with the objective occurrence data based, at least in part, on a determination of whether the at least one subjective user state occurred within a predefined time increment from incidence of the at least one objective occurrence as depicted in FIG. 4-7a. For instance, the correlation module 4-106 of the computing device 4-10 correlating the subjective user state data 4-60 with the objective occurrence data 4-70* based, at least in part, on a determination by the “within predefined time increment determination” module 4-238 (see FIG. 4-2d), of whether the at least one subjective user state occurred within a predefined time increment from incidence of the at least one objective occurrence.

In some implementations, operation 4-702 may include an operation 4-706 for correlating the subjective user state data with the objective occurrence data based, at least in part, on a determination of whether the at least one subjective user state occurred before, after, or at least partially concurrently with incidence of the at least one objective occurrence as depicted in FIG. 4-7a. For instance, the correlation module 4-106 of the computing device 4-10 correlating the subjective user state data 4-60 with the objective occurrence data 4-70* based, at least in part, on a determination by the temporal relationship determination module 4-239 of whether the at least one subjective user state occurred before, after, or at least partially concurrently with incidence of the at least one objective occurrence.

In some implementations, operation 4-702 may include an operation 4-708 for correlating the subjective user state data with the objective occurrence data based, at least in part, on referencing of historical data as depicted in FIG. 4-7a. For instance, the correlation module 4-106 of the computing device 4-10 correlating the subjective user state data 4-60 with the objective occurrence data 4-70* based, at least in part, on referencing by the historical data referencing module 4-241 of historical data 4-72 (e.g., population trends such as the superior efficacy of ibuprofen as opposed to acetaminophen in reducing toothaches in the general population, user medical data such as genetic, metabolome, or proteome information, historical sequential patterns particular to the user 4-20* or to the overall population such as people having a hangover after drinking excessively, and so forth).

In various implementations, operation 4-708 may include one or more additional operations. For example, in some implementations, operation 4-708 may include an operation 4-710 for correlating the subjective user state data with the objective occurrence data based, at least in part, on the historical data indicating a link between a subjective user state type and an objective occurrence type as depicted in FIG. 4-7a. For instance, the correlation module 4-106 of the computing device 4-10 correlating the subjective user state data 4-60 with the objective occurrence data 4-70* based, at least in part, on the historical data referencing module 4-241 referencing the historical data 4-72 indicative of a link between a subjective user state type and an objective occurrence type (e.g., historical data 4-72 suggests or indicates a link between a person's mental well-being and exercise).

In some instances, operation 4-710 may further include an operation 4-712 for correlating the subjective user state data with the objective occurrence data based, at least in part, on a historical sequential pattern as depicted in FIG. 4-7a. For instance, the correlation module 4-106 of the computing device 4-10 correlating the subjective user state data 4-60 with the objective occurrence data 4-70* based, at least in part, on a historical sequential pattern (e.g., a historical sequential pattern that indicates that people feel more alert after exercising or a historical sequential pattern associated with the user 4-20*).

For example, a previously determined historical sequential pattern associated with the user 4-20* may have been determined based on previously acquired data indicating occurrence of at least a second subjective user state 4-60b (see FIG. 4-1a) and data indicating occurrence of at least a second objective occurrence. As will be further described below, the previously determined historical sequential pattern (e.g., second sequential pattern) may then be compared with the determined one sequential pattern (see operation 4-702) associated with the at least one subjective user state and the at least one objective occurrence in order to correlate the subjective user state data 4-60 with the objective occurrence data 4-70*.

In some implementations, operation 4-708 may include an operation 4-714 for correlating the subjective user state data with the objective occurrence data based, at least in part, on historical medical data as depicted in FIG. 4-7a. For instance, the correlation module 4-106 of the computing device 4-10 correlating the subjective user state data 4-60 with the objective occurrence data 4-70* based, at least in part, on historical medical data (e.g., genetic, metabolome, or proteome information or medical records of the user 4-20* or of others related to, for example, diabetes or heart disease).

In some implementations, operation 4-702 may include an operation 4-716 for comparing the at least one sequential pattern to a second sequential pattern to determine whether the at least one sequential pattern at least substantially matches with the second sequential pattern as depicted in FIG. 4-7b. For instance, the sequential pattern comparison module 4-242 of the computing device 4-10 comparing the at least one sequential pattern to a second sequential pattern to determine whether the at least one sequential pattern at least substantially matches with the second sequential pattern.

In various implementations, operation 4-716 may further include an operation 4-718 for comparing the at least one sequential pattern to a second sequential pattern related to at least a second subjective user state associated with the user and a second objective occurrence to determine whether the at least one sequential pattern at least substantially matches with the second sequential pattern as depicted in FIG. 4-7b. For instance, the sequential pattern comparison module 4-242 of the computing device 4-10 comparing the at least one sequential pattern to a second sequential pattern related to at least a second subjective user state associated with the user 4-20* and a second objective occurrence to determine whether the at least one sequential pattern at least substantially matches with the second sequential pattern. In other words, comparing the at least one subjective user state and the at least one objective occurrence associated with the one sequential pattern to the at least a second subjective user state and the at least a second objective occurrence associated with the second sequential pattern in order to determine whether they substantially match (or do not match) as well as to determine whether respective temporal or time relationships associated with each of the one sequential pattern and the second sequential pattern substantially match.

In some implementations, the correlation operation 4-308 of FIG. 4-3 may include an operation 4-720 for correlating the subjective user state data with the objective occurrence data at a server as depicted in FIG. 4-7b. For instance, the correlation module 4-106 of the computing device 4-10 correlating the subjective user state data 4-60 with the objective occurrence data 4-70* when the computing device 4-10 is a network server.

In some implementations, the correlation operation 4-308 may include an operation 4-722 for correlating the subjective user state data with the objective occurrence data at a handheld device as depicted in FIG. 4-7b. For instance, the correlation module 4-106 of the computing device 4-10 correlating the subjective user state data 4-60 with the objective occurrence data 4-70* when the computing device 4-10 is a handheld device (e.g., a cellular telephone, a personal digital assistant, and so forth).

In some implementations, the correlation operation 4-308 may include an operation 4-724 for correlating the subjective user state data with the objective occurrence data at a peer-to-peer network component device as depicted in FIG. 4-7b. For instance, the correlation module 4-106 of the computing device 4-10 correlating the subjective user state data 4-60 with the objective occurrence data 4-70* when the computing device 4-10 is a peer-to-peer network component device.

Referring to FIG. 4-8 illustrating another operational flow 4-800 in accordance with various embodiments. Operational flow 4-800 includes operations that mirror the operations included in the operational flow 4-300 of FIG. 4-3. These operations include an objective occurrence data acquisition operation 4-802, a subjective user state data solicitation operation 4-804, a subjective user state data acquisition operation 4-806, and a correlation operation 4-808 that correspond to and mirror the objective occurrence data acquisition operation 4-302, the subjective user state data solicitation operation 4-304, the subjective user state data acquisition operation 4-306, and the correlation operation 4-308, respectively, of FIG. 4-3.

In addition, operational flow 4-800 includes a presentation operation 4-810 for presenting one or more results of the correlating as depicted in FIG. 4-8. For example, the presentation module 4-108 of the computing device 4-10 presenting (e.g., transmitting via a network interface 4-120 or providing via the user interface 4-122) one or more results of the correlating operation 4-808 as performed by the correlation module 4-106.

In various embodiments, the presentation operation 4-810 may include one or more additional operations as depicted in FIG. 4-9. For example, in some implementations, the presentation operation 4-810 may include an operation 4-902 for providing the one or more results of the correlating via a user interface. For instance, the user interface indication module 4-254 (see FIG. 4-2e) of the computing device 4-10 indicating (e.g., displaying or audibly providing) the one or more results (e.g., in the form of an advisory, a warning, an alert, a prediction, and so forth of a future or past result) of the correlating operation 4-808 performed by the correlation module 4-106 via a user interface 4-122 (e.g., a display monitor, a touchscreen, or an audio system including one or more speakers).

In some implementations, the presentation operation 4-810 may include an operation 4-904 for transmitting the one or more results of the correlating via a network interface. For instance, the network interface transmission module 4-252 (see FIG. 4-2e) of the computing device 4-10 transmitting the one or more results (e.g., in the form of an advisory, a warning, an alert, a prediction, and so forth of a future or past result) of the correlating operation 4-808 performed by the correlation module 4-106 via a network interface 4-120 (e.g., NIC).

In some implementations, the presentation operation 4-810 may include an operation 4-906 for presenting an indication of a sequential relationship between the at least one subjective user state and the at least one objective occurrence. For instance, the sequential relationship presentation module 4-256 of the computing device 4-10 presenting (e.g., transmitting via the network interface 4-120 or indicating via user interface 4-122) an indication of a sequential relationship between the at least one subjective user state (e.g., headache) and the at least one objective occurrence (e.g., drinking beer).

In some implementations, the presentation operation 4-810 may include an operation 4-908 for presenting a prediction of a future subjective user state resulting from a future objective occurrence associated with the user. For instance, the prediction presentation module 4-258 of the computing device 4-10 a prediction of a future subjective user state associated with the user 4-20* resulting from a future objective occurrence. An example prediction might state that “if the user drinks five shots of whiskey tonight, the user will have a hangover tomorrow.”

In some implementations, the presentation operation 4-810 may include an operation 4-910 for presenting a prediction of a future subjective user state resulting from a past objective occurrence associated with the user. For instance, the prediction presentation module 4-258 of the computing device 4-10 presenting a prediction of a future subjective user state associated with the user 4-20* resulting from a past objective occurrence. An example prediction might state that “the user will have a hangover tomorrow since the user drank five shots of whiskey tonight.”

In some implementations, the presentation operation 4-810 may include an operation 4-912 for presenting a past subjective user state in connection with a past objective occurrence associated with the user. For instance, the past presentation module 4-260 of the computing device 4-10 presenting a past subjective user state associated with the user 4-20* in connection with a past objective occurrence. An example of such a presentation might state that “the user got depressed the last time it rained.”

In some implementations, the presentation operation 4-810 may include an operation 4-914 for presenting a recommendation for a future action. For instance, the recommendation module 4-262 of the computing device 4-10 presenting a recommendation for a future action. An example recommendation might state that “the user should not drink five shots of whiskey.”

Operation 4-914 may, in some instances, include an additional operation 4-916 for presenting a justification for the recommendation. For instance, the justification module 4-264 of the computing device 4-10 presenting a justification for the recommendation. An example justification might state that “the user should not drink five shots of whiskey because the last time the user drank five shots of whiskey, the user got a hangover.”

VI: Correlating Data Indicating Subjective User States Associated with Multiple Users with Data Indicating Objective Occurrences

In the following detailed description, reference is made to the accompanying drawings, which form a part hereof. In the drawings, similar symbols typically identify similar components, unless context dictates otherwise. The illustrative embodiments described in the detailed description, drawings, and claims are not meant to be limiting. Other embodiments may be utilized, and other changes may be made, without departing from the spirit or scope of the subject matter presented here.

A recent trend that is becoming increasingly popular in the computing/communication field is to electronically record one's feelings, thoughts, and other aspects of the person's everyday life onto an open diary. One place where such open diaries are maintained are at social networking sites commonly known as “blogs” where one or more users may report or post their thoughts and opinions on various topics, latest news, and various other aspects of users everyday life. The process of reporting or posting blog entries is commonly referred to as blogging. Other social networking sites may allow users to update their personal information via, for example, social network status reports in which a user may report or post, for others to view, the latest status or other aspects of the user.

A more recent development in social networking is the introduction and explosive growth of microblogs in which individuals or users (referred to as “microbloggers”) maintain open diaries at microblog websites (e.g., otherwise known as “twitters”) by continuously or semi-continuously posting microblog entries. A microblog entry (e.g., “tweet”) is typically a short text message that is usually not more than 140 characters long. The microblog entries posted by a microblogger may report on any aspect of the microblogger's daily life.

The various things that are typically posted through microblog entries may be categorized into one of at least two possible categories. The first category of things that may be reported through microblog entries are “objective occurrences” that may be directly or indirectly associated with the microblogger. Objective occurrences that are associated with a microblogger may be any characteristic, event, happening, or any other aspect that may be directly or indirectly associated with or of interest to the microblogger that can be objectively reported by the microblogger, a third party, or by a device. These things would include, for example, food, medicine, or nutraceutical intake of the microblogger, certain physical characteristics of the microblogger such as blood sugar level or blood pressure that can be objectively measured, daily activities of the microblogger observable by others or by a device, the local weather, the stock market (which the microblogger may have an interest in), activities of others (e.g., spouse or boss) that may directly or indirectly affect the microblogger, and so forth.

A second category of things that may be reported or posted through microblogging entries include “subjective user states” of the microblogger. Subjective user states of a microblogger include any subjective state or status associated with the microblogger that can only be typically reported by the microblogger (e.g., generally cannot be reported by a third party or by a device). Such states including, for example, the subjective mental state of the microblogger (e.g., “I am feeling happy”), the subjective physical states of the microblogger (e.g., “my ankle is sore” or “my ankle does not hurt anymore” or “my vision is blurry”), and the subjective overall state of the microblogger (e.g., “I'm good” or “I'm well”). Note that the term “subjective overall state” as will be used herein refers to those subjective states that do not fit neatly into the other two categories of subjective user states described above (e.g., subjective mental states and subjective physical states). Although microblogs are being used to provide a wealth of personal information, they have only been primarily limited to their use as a means for providing commentaries and for maintaining open diaries.

In accordance with various embodiments, methods, systems, and computer program products are provided for, among other things, correlating subjective user state data including data indicating incidences of one or more subjective user states of multiple users with objective occurrence data including data indicating incidences of one or more objective occurrences. In doing so, a causal relationship between one or more objective occurrences (e.g., cause) and one or more subjective user states (e.g., result) associated with multiple users (e.g., bloggers or microbloggers) may be determined in various alternative embodiments. For example, determining that eating a banana (e.g., objective occurrence) may result in a user feeling good (e.g., subjective user state) or determining that users will usually or always feel satisfied or good whenever they eat bananas. Note that an objective occurrence does not need to occur prior to a corresponding subjective user state but instead, may occur subsequent or concurrently with the incidence of the subjective user state. For example, a person may become “gloomy” (e.g., subjective user state) whenever it is about to rain (e.g., objective occurrence) or a person may become gloomy while (e.g., concurrently) it is raining

In various embodiments, subjective user state data may include data indicating subjective user states of multiple users. A “subjective user state,” as will be used herein, may be in reference to any subjective state or status associated with a particular user (e.g., a particular blogger or microblogger) at any moment or interval in time that only the user can typically indicate or describe. Such states include, for example, the subjective mental state of a user (e.g., user is feeling sad), the subjective physical state (e.g., physical characteristic) of a user that only the user can typically indicate (e.g., a backache or an easing of a backache as opposed to blood pressure which can be reported by a blood pressure device and/or a third party), and the subjective overall state of a user (e.g., user is “good”). Examples of subjective mental states include, for example, happiness, sadness, depression, anger, frustration, elation, fear, alertness, sleepiness, and so forth. Examples of subjective physical states include, for example, the presence, easing, or absence of pain, blurry vision, hearing loss, upset stomach, physical exhaustion, and so forth. Subjective overall states may include any subjective user states that cannot be categorized as a subjective mental state or as a subjective physical state. Examples of overall states of a user that may be subjective user states include, for example, the user being good, bad, exhausted, lack of rest, wellness, and so forth.

In contrast, “objective occurrence data,” which may also be referred to as “objective context data,” may include data that indicate one or more objective occurrences that may or may not be directly or indirectly associated with one or more users. In particular, an objective occurrence may be a physical characteristic, an event, one or more happenings, or any other aspect that may be associated with or is of interest to a user (or a group of users) that can be objectively reported by at least a third party or a sensor device. Note, however, that the occurrence or incidence of an objective occurrence does not have to be actually provided by a sensor device or by a third party, but instead, may be reported by a user or a group of users. Examples of an objective occurrence that could be indicated by the objective occurrence data include, for example, a user's food, medicine, or nutraceutical intake, a user's location at any given point in time, a user's exercise routine, a user's blood pressure, weather at a user's or a group of users' location, activities associated with third parties, the stock market, and so forth.

The term “correlating” as will be used herein is in reference to a determination of one or more relationships between at least two variables. In the following exemplary embodiments, the first variable is subjective user state data that represents multiple subjective user states of multiple users and the second variable is objective occurrence data that represents one or more objective occurrences. Each of the subjective user states represented by the subjective user state data may be associated with a respective user and may or may not be the same or similar type of subjective user state. Similarly, when multiple objective occurrences are represented by the objective occurrence data, each of the objective occurrences indicated by the objective occurrence data may or may not represent the same or similar type of objective occurrence.

Various techniques may be employed for correlating the subjective user state data with the objective occurrence data. For example, in some embodiments, correlating the objective occurrence data with the subjective user state data may be accomplished by determining a first sequential pattern for a first user, the first sequential pattern being associated with at least a first subjective user state (e.g., upset stomach) associated with the first user and at least a first objective occurrence (e.g., first user eating spicy food).

A second sequential pattern may also be determined for a second user, the second sequential pattern being associated with at least a second subjective user state (e.g., upset stomach) associated the second user and at least a second objective occurrence (second user eating spicy food). The subjective user state data (which may indicate the subjective user states of the first and the second user) and the objective occurrence data (which may indicate the first and the second objective occurrence) may then be correlated by comparing the first sequential pattern with the second sequential pattern. In doing so, for example, a hypothesis may be determined indicating that, for example, eating spicy foods causes upset stomachs.

Note that in some cases, the first and second objective occurrences indicated by the objective occurrence data could actually be the same objective occurrence. For example, the first and second objective occurrence could be related to the weather at a particular location (and therefore, potentially affect multiple users). However, since a single objective occurrence event such as weather could be reported via different sources (e.g., different users or third party sources), a single objective occurrence event could be indicated multiple times by the objective occurrence data. In still other variations, the first and the second objective occurrences may be the same or similar types of objective occurrences (e.g., bad weather on different days or different locations). In still other variations, the first and the second objective occurrences could be different objective occurrences (e.g., sunny weather as opposed to stormy weather) or variations of each other (e.g., a blizzard as opposed to light snow).

Similarly, the first and the second subjective user states of the first and second users may, in some instances, be the same or similar type of subjective user states (e.g., the first and second both feeling happy). In other situations, they may not be the same or similar type of subjective user state. For example, the first user may have had a very bad upset stomach (e.g., first subjective user state) after eating spicy food while the second user may only have had a mild upset stomach or no upset stomach after eating spicy food. In such a scenario, this may indicate a weaker correlation between spicy foods and upset stomachs.

As will be further described herein a sequential pattern, in some implementations, may merely indicate or represent the temporal relationship or relationships between at least one subjective user state associated with a user and at least one objective occurrence (e.g., whether the incidence or occurrence of the at least one subjective user state occurred before, after, or at least partially concurrently with the incidence of the at least one objective occurrence). In alternative implementations, and as will be further described herein, a sequential pattern may indicate a more specific time relationship between incidences of one or more subjective user states associated with a user and incidences of one or more objective occurrences. For example, a sequential pattern may represent the specific pattern of events (e.g., one or more objective occurrences and one or more subjective user states) that occurs along a timeline.

The following illustrative example is provided to describe how a sequential pattern associated with at least one subjective user state associated with a user and at least one objective occurrence may be determined based, at least in part, on the temporal relationship between the incidence of the at least one subjective user state and the incidence of the at least one objective occurrence in accordance with some embodiments. For these embodiments, the determination of a sequential pattern may initially involve determining whether the incidence of the at least one subjective user state occurred within some predefined time increments of the incidence of the one objective occurrence. That is, it may be possible to infer that those subjective user states that did not occur within a certain time period from the incidence of an objective occurrence are not related or are unlikely related to the incidence of that objective occurrence.

For example, suppose a user during the course of a day eats a banana and also has a stomach ache sometime during the course of the day. If the consumption of the banana occurred in the early morning hours but the stomach ache did not occur until late that night, then the stomach ache may be unrelated to the consumption of the banana and may be disregarded. On the other hand, if the stomach ache had occurred within some predefined time increment, such as within 2 hours of consumption of the banana, then it may be concluded that there may be a link between the stomach ache and the consumption of the banana. If so, a temporal relationship between the consumption of the banana and the occurrence of the stomach ache may be determined. Such a temporal relationship may be represented by a sequential pattern that may simply indicate that the stomach ache (e.g., a subjective user state) occurred after (rather than before or concurrently with) the consumption of banana (e.g., an objective occurrence).

As will be further described herein, other factors may also be referenced and examined in order to determine a sequential pattern and whether there is a relationship (e.g., causal relationship) between an objective occurrence and a subjective user state. These factors may include, for example, historical data (e.g., historical medical data such as genetic data or past history of the user or historical data related to the general population regarding stomach aches and bananas). Alternatively, a sequential pattern may be determined for multiple subjective user states associated with a single user and multiple objective occurrences. Such a sequential pattern may particularly map the exact temporal or time sequencing of various events (e.g., subjective user states and/or objective occurrences). The determined sequential pattern may then be used to provide useful information to the user and/or third parties.

The following is another illustrative example of how subjective user state data may be correlated with objective occurrence data by determining multiple sequential patterns and comparing the sequential patterns with each other. Suppose, for example, a first user such as a microblogger reports that the first user ate a banana. The consumption of the banana, in this example, is a reported first objective occurrence associated with the first user. The first user then reports that 15 minutes after eating the banana, the user felt very happy. The reporting of the emotional state (e.g., felt very happy) is, in this example, a reported first subjective user state associated with the first user. Thus, the reported incidence of the first objective occurrence (e.g., eating the banana) and the reported incidence of the first subjective user state (user felt very happy) may be represented by a first sequential pattern.

A second user reports that the second user also ate a banana (e.g., a second objective occurrence). The second user then reports that 20 minutes after eating the banana, the user felt somewhat happy (e.g., a second subjective user state associated with the second user). Thus, the reported incidence of the second objective occurrence (e.g., eating the banana by the second user) and the reported incidence of the second subjective user state (second user felt somewhat happy) may then be represented by a second sequential pattern. Note that in this example, the occurrences of the first subjective user state associated with the first user and the second subjective user state associated with the second user may be indicated by subjective user state data while the occurrences of the first objective occurrence and the second objective occurrence may be indicated by objective occurrence data.

By comparing the first sequential pattern with the second sequential pattern, the subjective user state data may be correlated with the objective occurrence data. In some implementations, the comparison of the first sequential pattern with the second sequential pattern may involve trying to match the first sequential pattern with the second sequential pattern by examining certain attributes and/or metrics. For example, comparing the first subjective user state (e.g., the first user felt very happy) of the first sequential pattern with the second subjective user state (e.g., the second user felt somewhat happy) of the second sequential pattern to see if they at least substantially match or are contrasting (e.g., being very happy in contrast to being slightly happy or being happy in contrast to being sad). Similarly, comparing the first objective occurrence (e.g., the first user eating a banana) of the first sequential pattern may be compared to the second objective occurrence (e.g., the second user eating a banana) of the second sequential pattern to determine whether they at least substantially match or are contrasting.

A comparison may also be made to see if the extent of time difference (e.g., 15 minutes) between the first subjective user state (e.g., first user being very happy) and the first objective occurrence (e.g., first user eating a banana) matches or are at least similar to the extent of time difference (e.g., 20 minutes) between the second subjective user state (e.g., second user being somewhat happy) and the second objective occurrence (e.g., second user eating a banana). These comparisons may be made in order to determine whether the first sequential pattern matches the second sequential pattern. A match or substantial match would suggest, for example, that a subjective user state (e.g., happiness) is linked to an objective occurrence (e.g., consumption of banana).

As briefly described above, the comparison of the first sequential pattern with the second sequential pattern may include a determination as to whether, for example, the respective subjective user states and the respective objective occurrences of the sequential patterns are contrasting subjective user states and/or contrasting objective occurrences. For example, suppose in the above example the first user had reported that the first user had eaten a whole banana and felt very energetic (e.g., first subjective user state) after eating the whole banana (e.g., first objective occurrence). Suppose that the second user reports eating a half a banana instead of a whole banana and only felt slightly energetic (e.g., second subjective user state) after eating the half banana (e.g., second objective occurrence). In this scenario, the first sequential pattern (e.g., first user feeling very energetic after eating a whole banana) may be compared to the second sequential pattern (e.g., second user feeling slightly energetic after eating only a half of a banana) to at least determine whether the first subjective user state (e.g., first user being very energetic) and the second subjective user state (e.g., second user being slightly energetic) are contrasting subjective user states. Another determination may also be made during the comparison to determine whether the first objective occurrence (first user eating a whole banana) is in contrast with the second objective occurrence (e.g., second user eating a half of a banana).

In doing so, an inference may be made that eating a whole banana instead of eating only a half of a banana makes a user happier or eating more banana makes a user happier. Thus, the word “contrasting” as used here with respect to subjective user states refers to subjective user states that are the same type of subjective user states (e.g., the subjective user states being variations of a particular type of subjective user states such as variations of subjective mental states). Thus, for example, the first subjective user state and the second subjective user state in the previous illustrative example are merely variations of subjective mental states (e.g., happiness). Similarly, the use of the word “contrasting” as used here with respect to objective occurrences refers to objective states that are the same type of objective occurrences (e.g., consumption of a food item such as a banana).

As those skilled in the art will recognize, a stronger correlation between subjective user state data and objective occurrence data may be obtained if a greater number of sequential patterns (e.g., if there was a third sequential pattern associated with a third user, a fourth sequential pattern associated with a fourth user, and so forth) that indicated that a user becomes happy or happier whenever a user eats a banana) are used as a basis for the correlation. Note that for ease of explanation and illustration, each of the exemplary sequential patterns to be described herein will be depicted as a sequential pattern associated with incidence of a single subjective user state and incidence of a single objective occurrence. However, those skilled in the art will recognize that a sequential pattern, as will be described herein, may also be associated with incidences of multiple objective occurrences and/or multiple subjective user states. For example, suppose a user had reported that after eating a banana, he had gulped down a can of soda. The user then reports that he became happy but had an upset stomach. In this example, the sequential pattern associated with this scenario will be associated with two objective occurrences (e.g., eating a banana and drinking a can of soda) and two subjective user states (e.g., user having an upset stomach and feeling happy).

In some embodiments, and as briefly described earlier, the sequential patterns derived from subjective user state data and objective occurrence data may be based on temporal relationships between objective occurrences and subjective user states. For example, whether a subjective user state occurred before, after, or at least partially concurrently with an objective occurrence. For instance, a plurality of sequential patterns derived from subjective user state data and objective occurrence data may indicate that a user always has a stomach ache (e.g., subjective user state) after eating a banana (e.g., first objective occurrence).

FIGS. 5-1a and 5-1b illustrate an example environment in accordance with various embodiments. In the illustrated environment, an exemplary system 5-100 may include at least a computing device 5-10 (see FIG. 5-1b) that may be employed in order to, among other things, collect subjective user state data 5-60 and objective occurrence data 5-70*, and to correlate the subjective user state data 5-60 with the objective occurrence data 5-70*. Note that in the following, “*” indicates a wildcard. Thus, user 5-20* may represent a first user 5-20a, a second user 5-20b, a third user 5-20c, a fourth user 5-20d, and/or other users 5-20* as illustrated in FIGS. 5-1a and 5-1b.

In some embodiments, the computing device 5-10 may be a network server in which case the computing device 5-10 may communicate with a plurality of users 5-20* via mobile devices 5-30* and through a wireless and/or wired network 5-40. A network server, as will be described herein, may be in reference to a network server located at a single network site or located across multiple network sites or a conglomeration of servers located at multiple network sites. A mobile device 5-30* may be a variety of computing/communication devices including, for example, a cellular phone, a personal digital assistant (PDA), a laptop, a desktop, or other types of computing/communication device that can communicate with the computing device 5-10.

In alternative embodiments, the computing device 5-10 may be a local computing device such as a client device that communicates directly with one or more users 5-20* as indicated by ref 21 as illustrated in FIG. 5-1b. For these embodiments, the computing device 5-10 may be any type of handheld device such as a cellular telephone or a PDA, or other types of computing/communication devices such as a laptop computer, a desktop computer, a workstation, and so forth. In certain embodiments, the computing device 5-10 may be a peer-to-peer network component device. In some embodiments, the computing device 5-10 may operate via a web 2.0 construct.

In embodiments where the computing device 5-10 is a server, the computing device 5-10 may obtain subjective user state data 5-60 indirectly from one or more users 5-20* via a network interface 5-120. Alternatively, the subjective user state data 5-60 may be received from one or more third party sources 5-50 such as other network servers. In still other embodiments, subjective user state data 5-60 may be retrieved from a memory 5-140. In embodiments in which the computing device 5-10 is a local device rather than a server, the subjective user state data 5-60 may be directly obtained from one or more users 5-20* via a user interface 5-122. As will be further described herein, the computing device 5-10 may acquire the objective occurrence data 5-70* from one or more sources.

For ease of illustration and explanation, the following systems and operations to be described herein will be generally described in the context of the computing device 5-10 being a network server. However, those skilled in the art will recognize that these systems and operations may also be implemented when the computing device 5-10 is a local device such as a handheld device that may communicate directly with one or more users 5-20*.

Assuming that the computing device 5-10 is a server, the computing device 5-10, in some implementations, may be configured to acquire subjective user state data 5-60 including data indicating incidence of at least a first subjective user state 5-60a associated with a first user 5-20a and data indicating incidence of at least a second subjective user state 5-60b associated with a second user 5-20b via mobile devices 5-30a and 5-30b and through wireless and/or wired networks 5-40. In some embodiments, the subjective user state data 5-60 may further include data indicating incidence of at least a third subjective user state 5-60c associated with a third user 5-20c, data indicating incidence of at least a fourth subjective user state 5-60d associated with a fourth user 5-20d, and so forth.

In various embodiments, the data indicating incidence of at least a first subjective user state 5-60a associated with a first user 5-20a, as well as the data indicating incidence of at least a second subjective user state 5-60b associated with a second user 5-20b may be acquired in the form of blog entries, such as microblog entries, status reports (e.g., social networking status reports), electronic messages (email, text messages, instant messages, etc.) or other types of electronic messages or documents. The data indicating the incidence of at least a first subjective user state 5-60a and the data indicating the incidence of at least a second subjective user state 5-60b may, in some instances, indicate the same, contrasting, or completely different subjective user states. Examples of subjective user states that may be indicated by the subjective user state data 5-60 include, for example, subjective mental states of a user 5-20* (e.g., a user 5-20* is sad or angry), subjective physical states of a user 5-20* (e.g., physical or physiological characteristic of a user 5-20* such as the presence or absence of a stomach ache or headache), and/or subjective overall states of a user 5-20* (e.g., a user 5-20* is “well” or any other subjective states that may not be classified as a subjective physical state or a subjective mental state).

The computing device 5-10 may be further configured to acquire objective occurrence data 5-70* from one or more sources. In various embodiments, the objective occurrence data 5-70* acquired by the computing device 5-10 may include data indicative of at least one objective occurrence. In some embodiments, the objective occurrence data 5-70* may include at least data indicating incidence of at least a first objective occurrence and data indicating incidence of at least a second objective occurrence, wherein the first and the second objective occurrence may or may not be the same objective occurrence (e.g., stormy weather on a particular day that may affect multiple users 5-20*). In some embodiments, the first objective occurrence may be associated with the first user 5-20a (e.g., physical characteristic of the first user 5-20a) while the second objective occurrence may be associated with the second user 5-20b. (e.g., physical characteristic of the second user 5-20b).

The objective occurrence data 5-70* may be acquired from various sources. For example, in some embodiments, objective occurrence data 5-70a may be acquired from one or more third party sources 5-50 (e.g., one or more third parties). Examples of third party sources 5-50 include, for example, network servers and other network devices associated with third parties. Examples of third parties include, for example, other users 5-20*, a health care provider, a hospital, a place of employment, a content provider, and so forth.

In some embodiments, objective occurrence data 5-70b may be acquired from one or more sensors 5-35 for sensing or monitoring various aspects associated with one or more users 5-20*. For example, in some implementations, sensors 5-35 may include a global positioning system (GPS) device for determining the locations of one or more users 5-20* or a physical activity sensor for measuring physical activities of one or more users 5-20*. Examples of a physical activity sensor include, for example, a pedometer for measuring physical activities of one or more users 5-20*. In certain implementations, the one or more sensors 5-35 may include one or more physiological sensor devices for measuring physiological characteristics of one or more users 5-20*. Examples of physiological sensor devices include, for example, a blood pressure monitor, a heart rate monitor, a glucometer, and so forth. In some implementations, the one or more sensors 5-35 may include one or more image capturing devices such as a video or digital camera.

In some embodiments, objective occurrence data 5-70c may be acquired from one or more users 5-20* via one or more mobile devices 5-30*. For these embodiments, the objective occurrence data 5-70c may be in the form of blog entries (e.g., microblog entries), status reports, or other types of electronic messages that may be generated by one or more users 5-20*. In various implementations, the objective occurrence data 5-70c acquired from one or more users 5-20* may indicate, for example, activities (e.g., exercise or food or medicine intake) performed by one or more users 5-20*, certain physical characteristics (e.g., blood pressure or location) associated with one or more users 5-20*, or other aspects associated with one or more users 5-20* that the one or more users 5-20* can report objectively. In still other implementations, objective occurrence data 5-70* may be acquired from a memory 5-140.

After acquiring the subjective user state data 5-60 and the objective occurrence data 5-70*, the computing device 5-10 may be configured to correlate the acquired subjective user data 5-60 with the acquired objective occurrence data 5-70* based, at least in part, on a determination of multiple sequential patterns including at least a first sequential pattern and a second sequential pattern. The first sequential pattern being a sequential pattern of at least the first subjective user state and at least the first objective occurrence, and the second sequential pattern being a sequential pattern of at least the second subjective user state and at least the second objective occurrence, the first subjective user state being associated with the first user 5-20a and the second subjective user state being associated with the second user 5-20b. The determined sequential patterns may then be compared to each other in order to correlate the subjective user state data 5-60 with the objective occurrence data 5-70*.

In some embodiments, and as will be further indicated in the operations and processes to be described herein, the computing device 5-10 may be further configured to present one or more results of the correlation operation. In various embodiments, one or more correlation results 5-80 may be presented to one or more users 5-20* and/or to one or more third parties (e.g., one or more third party sources 5-50) in various alternative forms. The one or more third parties may be other users 5-20* such as other microbloggers, health care providers, advertisers, and/or content providers.

As illustrated in FIG. 5-1b, computing device 5-10 may include one or more components or sub-modules. For instance, in various implementations, computing device 5-10 may include a subjective user state data acquisition module 5-102, an objective occurrence data acquisition module 5-104, a correlation module 5-106, a presentation module 5-108, a network interface 5-120, a user interface 5-122, one or more applications 5-126, and/or memory 5-140. The functional roles of these components/modules will be described in the processes and operations to be described herein.

FIG. 5-2a illustrates particular implementations of the subjective user state data acquisition module 5-102 of the computing device 5-10 of FIG. 5-1b. In brief, the subjective user state data acquisition module 5-102 may be designed to, among other things, acquire subjective user state data 5-60 including at least data indicating incidence of at least a first subjective user state 5-60a associated with a first user 5-20a and data indicating incidence of at least a second subjective user state 5-60b associated with a second user 5-20b. As further illustrated, the subjective user state data acquisition module 5-102, in various embodiments, may include a reception module 5-202 designed to, among other things, receive subjective user state data 5-60 including receiving one, or both, of the data indicating incidence of at least a first subjective user state 5-60a and the data indicating incidence of at least a second subjective user state 5-60b. In various embodiments, the reception module 5-202 may be configured to receive the subjective user state data 5-60 via a network interface 5-120 (e.g., network interface card or NIC) and/or via a user interface 5-122 (e.g., a display monitor, a keyboard, a touch screen, a mouse, a keypad, a microphone, a camera, and/or other interface devices).

In some implementations, the reception module 5-202 may further include an electronic message reception module 5-204, a blog entry reception module 5-205, a status report reception module 5-206, a text entry reception module 5-207, an audio entry reception module 5-208, and/or an image entry reception module 5-209. In brief, and as will be further described in the processes and operations to be described herein, the electronic message reception module 5-204 may be configured to acquire subjective user state data 5-60 including one, or both, of the data indicating incidence of at least a first subjective user state 5-60a and the data indicating incidence of at least a second subjective user state 5-60b in the form of one or more electronic messages (e.g., text message, email, and so forth).

In contrast, the blog entry reception module 5-205 may be configured to receive subjective user state data 5-60 including one, or both, of the data indicating incidence of at least a first subjective user state 5-60a and the data indicating incidence of at least a second subjective user state 5-60b in the form of one or more blog entries (e.g., microblog entries). The status report reception module 5-206 may be configured to receive subjective user state data 5-60 including one, or both, of the data indicating incidence of at least a first subjective user state 5-60a and the data indicating incidence of at least a second subjective user state 5-60b via one or more status reports (e.g., social networking status reports).

The text entry reception module 5-207 may be configured to receive subjective user state data 5-60 including one, or both, of the data indicating incidence of at least a first subjective user state 5-60a and the data indicating incidence of at least a second subjective user state 5-60b via one or more text entries. The audio entry reception module 5-208 may be configured to receive subjective user state data 5-60 including one, or both, of the data indicating incidence of at least a first subjective user state 5-60a and the data indicating incidence of at least a second subjective user state 5-60b via one or more audio entries (e.g., audio recordings of user voice). The image entry reception module 5-209 may be configured to receive subjective user state data 5-60 including one, or both, of the data indicating incidence of at least a first subjective user state 5-60a and the data indicating incidence of at least a second subjective user state 5-60b via one or more image entries (e.g., digital still or motion images showing, for example, one or more gestures made by one or more users 5-20* and/or one or more facial expressions of one or more users 5-20*).

In some embodiments, the subjective user state data acquisition module 5-102 may include a time stamp acquisition module 5-210 designed to acquire (e.g., by receiving or by self-generating) one or more time stamps associated with incidences of one or more subjective user states associated with one or more users 5-20*. In some embodiments, the subjective user state data acquisition module 5-102 may include a time interval indication acquisition module 5-211 designed to acquire (e.g., by receiving or by self-generating) one or more indications of time intervals associated with incidences of one or more subjective user states associated with one or more users 5-20*. In some embodiments, the subjective user state data acquisition module 5-102 may include a temporal relationship indication acquisition module 5-212 designed to acquire (e.g., by receiving or by self-generating) one or more indications of temporal relationships associated with incidences of one or more subjective user states associated with one or more users 5-20*.

In some embodiments, the subjective user state data acquisition module 5-102 may include a solicitation module 5-213 configured to solicit subjective user state data 5-60 including soliciting at least one, or both, of the data indicating incidence of at least a first subjective user state 5-60a and data indicating incidence of at least a second subjective user state 5-60b. In various embodiments, the solicitation module 5-213 may solicit the subjective user state data 5-60 from one or more users 5-20* via a network interface 5-120 (e.g., in the case where the computing device 5-10 is a network server) or via a user interface 5-122 (e.g., in the case where the computing device 5-10 is a local device used directly by a user 5-20b). In some alternative implementations, the solicitation module 5-213 may solicit the subjective user state data 5-60 from one or more third party sources 5-50 (e.g., network servers associated with third parties).

In some embodiments, the solicitation module 5-213 may include a request transmit/indicate module 5-214 configured to transmit (e.g., via network interface 5-120) and/or to indicate (e.g., via a user interface 5-122) a request for subjective user state data 5-60 including requesting for at least one, or both, of the data indicating incidence of at least a first subjective user state 5-60a and data indicating incidence of at least a second subjective user state 5-60b. In some implementations, the solicitation of the subjective user state data 5-60 may involve requesting a user 5-20* to select one or more subjective user states from a list of alternative subjective user state options (e.g., a user 5-20* may choose at least one from a choice of “I'm feeling alert,” “I'm feeling sad,” “My back is hurting,” “I have an upset stomach,” and so forth). In certain embodiments, the request to select from a list of alternative subjective user state options may mean requesting a user 5-20* to select one subjective user state from at least two contrasting subjective user state options (e.g., “I'm feeling good” or “I'm feeling bad”).

Referring now to FIG. 5-2b illustrating particular implementations of the objective occurrence data acquisition module 5-104 of the computing device 5-10 of FIG. 5-1b. In various implementations, the objective occurrence data acquisition module 5-104 may be configured to acquire (e.g., receive, solicit, and/or retrieve from a user 5-20*, one or more third party sources 5-50, one or more sensors 5-35, and/or a memory 5-140) objective occurrence data 5-70* including data indicative of incidences of one or more objective occurrences that may be directly or indirectly associated with one or more users 5-20*. Note that an objective occurrence such as the incidence of a particular physical characteristic of a user 5-20* may be directly associated with the user 5-20* while an objective occurrence such as the local weather on a particular day may be indirectly associated with a user 5-20*. In some embodiments, the objective occurrence data acquisition module 5-104 may include an objective occurrence data reception module 5-215 configured to receive (e.g., via network interface 5-120 or via user interface 5-122) objective occurrence data 5-70* including receiving at least data indicating incidence of at least a first objective occurrence and data indicating incidence of at least a second objective occurrence. In some situations, the first objective occurrence and the second objective occurrence may be the same objective occurrence (e.g., local weather that may affect multiple users 5-20*).

In various embodiments, the objective occurrence data reception module 5-215 may include a blog entry reception module 5-216 and/or a status report reception module 5-217. The blog entry reception module 5-216 may be designed to receive (e.g., via a network interface 5-120 or via a user interface 5-122) the objective occurrence data 5-70* including receiving one, or both, of the data indicating incidence of at least a first objective occurrence and the data indicating incidence of at least a second objective occurrence in the form of one or more blog entries (e.g., microblog entries). Such blog entries may be generated by one or more users 5-20* or by one or more third party sources 5-50.

In contrast, the status report reception module 5-217 may be designed to receive (e.g., via a network interface 5-120 or via a user interface 5-122) the objective occurrence data 5-70* including receiving one, or both, of the data indicating incidence of at least a first objective occurrence and the data indicating incidence of at least a second objective occurrence in the form of one or more status reports (e.g., social networking status reports). Such status reports may be provided by one or more users 5-20* or by one or more third party sources 5-50. Although not depicted, the objective occurrence data acquisition module 5-104 may additionally include an electronic message reception module for receiving the objective occurrence data 5-70* via one or more electronic messages (e.g., email, text message, and so forth).

In the same or different embodiments, the objective occurrence data acquisition module 5-104 may include a time stamp acquisition module 5-218 for acquiring (e.g., either by receiving or self-generating) one or more time stamps associated with one or more objective occurrences. In the same or different implementations, the objective occurrence data acquisition module 5-104 may include a time interval indication acquisition module 5-219 for acquiring (e.g., either by receiving or self-generating) indications of one or more time intervals associated with one or more objective occurrences. Although not depicted, in some implementations, the objective occurrence data acquisition module 5-104 may include a temporal relationship indication acquisition module for acquiring indications of temporal relationships associated with objective occurrences (e.g., indications that objective occurrences occurred before, after, or at least partially concurrently with incidences of subjective user states).

Turning now to FIG. 5-2c illustrating particular implementations of the correlation module 5-106 of the computing device 5-10 of FIG. 5-1b. The correlation module 5-106 may be configured to, among other things, correlate subjective user state data 5-60 with objective occurrence data 5-70* based, at least in part, on a determination of at least one sequential pattern of at least a first objective occurrence and at least a first subjective user state associated with a first user 5-20a. In various embodiments, the correlation module 5-106 may include a sequential pattern determination module 5-220 configured to determine one or more sequential patterns, where each sequential pattern is associated with at least one subjective user state of at least one user 5-20* and at least one objective occurrence.

The sequential pattern determination module 5-220, in various implementations, may include one or more sub-modules that may facilitate in the determination of one or more sequential patterns. As depicted, the one or more sub-modules that may be included in the sequential pattern determination module 5-220 may include, for example, a “within predefined time increment determination” module 5-221 and/or a temporal relationship determination module 5-222. In brief, the within predefined time increment determination module 5-221 may be configured to determine whether, for example, a subjective user state associated with a user 5-20* occurred within a predefined time increment from an incidence of an objective occurrence. For example, determining whether a user 5-20* feeling “bad” (i.e., a subjective user state) occurred within ten hours (i.e., predefined time increment) of eating a large chocolate sundae (i.e., an objective occurrence). Such a process may be used in order to determine that reported events, such as objective occurrences and subjective user states, are not or likely not related to each other, or to facilitate in determining the strength of correlation between subjective user states as identified by subjective user state data 5-60 and objective occurrences as identified by objective occurrence data 5-70*.

The temporal relationship determination module 5-222 may be configured to determine the temporal relationships between one or more subjective user states and one or more objective occurrences. For example, this may entail determining whether a particular subjective user state (e.g., sore back) of a user 5-20* occurred before, after, or at least partially concurrently with incidence of an objective occurrence (e.g., sub-freezing temperature).

In various embodiments, the correlation module 5-106 may include a sequential pattern comparison module 5-224. As will be further described herein, the sequential pattern comparison module 5-224 may be configured to compare multiple sequential patterns with each other to determine, for example, whether the sequential patterns at least substantially match each other or to determine whether the sequential patterns are contrasting sequential patterns. In some embodiments, at least two of the sequential patterns to be compared may be associated with different users 5-20*. For example, the sequential pattern comparison module 5-224 may be designed to compare a first sequential pattern of incidence of at least a first subjective user state and incidence of at least a first objective occurrence to a second sequential pattern of incidence of at least a second subjective user state and incidence of at least a second objective occurrence. For these embodiments, the first subjective user state may be a subjective user state associated with a first user 5-20a and the second subjective user state may be a subjective user state associated with a second user 5-20b.

As depicted in FIG. 5-2c, in various implementations, the sequential pattern comparison module 5-224 may further include one or more sub-modules that may be employed in order to, for example, facilitate in the comparison between different sequential patterns. For example, in various implementations, the sequential pattern comparison module 5-224 may include one or more of a subjective user state equivalence determination module 5-225, an objective occurrence equivalence determination module 5-226, a subjective user state contrast determination module 5-227, an objective occurrence contrast determination module 5-228, and/or a temporal relationship comparison module 5-229.

The subjective user state equivalence determination module 5-225 may be configured to determine whether subjective user states associated with different sequential patterns are equivalent. For example, the subjective user state equivalence determination module 5-225 may be designed to determine whether a first subjective user state associated with a first user 5-20a of a first sequential pattern is equivalent to a second subjective user state associated with a second user 5-20b of a second sequential pattern. For instance, suppose a first user 5-20a reports that he had a stomach ache (e.g., first subjective user state) after eating at a particular restaurant (e.g., a first objective occurrence), and suppose further a second user 5-20b also reports having a stomach ache (e.g., a second subjective user state) after eating at the same restaurant (e.g., a second objective occurrence, then the subjective user state equivalence determination module 5-225 may be employed in order to compare the first subjective user state (e.g., stomach ache) with the second subjective user state (e.g., stomach ache) to determine whether they are at least equivalent.

In contrast, the objective occurrence equivalence determination module 5-226 may be configured to determine whether objective occurrences of different sequential patterns are equivalent. For example, the objective occurrence equivalence determination module 5-226 may be designed to determine whether a first objective occurrence of a first sequential pattern is equivalent to a second objective occurrence of a second sequential pattern. For instance, for the above example the objective occurrence equivalence determination module 5-226 may compare eating at the particular restaurant by the first user 5-20a (e.g., first objective occurrence) with eating at the same restaurant (e.g., second objective occurrence) by the second user 5-20b in order to determine whether the first objective occurrence is equivalent to the second objective occurrence.

In some implementations, the sequential pattern comparison module 5-224 may include a subjective user state contrast determination module 5-227, which may be configured to determine whether subjective user states associated with different sequential patterns are contrasting subjective user states. For example, the subjective user state contrast determination module 5-227 may determine whether a first subjective user state associated with a first user 5-20a of a first sequential pattern is a contrasting subjective user state from a second subjective user state associated with a second user 5-20b of a second sequential pattern. For instance, suppose a first user 5-20a reports that he felt very “good” (e.g., first subjective user state) after jogging for an hour (e.g., first objective occurrence), while a second user 5-20b reports that he felt “bad” (e.g., second subjective user state) when he did not exercise (e.g., second objective occurrence), then the subjective user state contrast determination module 5-227 may compare the first subjective user state (e.g., feeling good) with the second subjective user state (e.g., feeling bad) to determine that they are contrasting subjective user states.

In some implementations, the sequential pattern comparison module 5-224 may include an objective occurrence contrast determination module 5-228 that may be configured to determine whether objective occurrences of different sequential patterns are contrasting objective occurrences. For example, the objective occurrence contrast determination module 5-228 may determine whether a first objective occurrence of a first sequential pattern is a contrasting objective occurrence from a second objective occurrence of a second sequential pattern. For instance, for the above example, the objective occurrence contrast determination module 5-228 may be configured to compare the first user 5-20a jogging (e.g., first objective occurrence) with the no jogging or exercise by the second user 5-20b (e.g., second objective occurrence) in order to determine whether the first objective occurrence is a contrasting objective occurrence from the second objective occurrence. Based on the contrast determination, an inference may be made that a user 5-20* may feel better by jogging rather than by not jogging at all.

In some embodiments, the sequential pattern comparison module 5-224 may include a temporal relationship comparison module 5-229, which may be configured to make comparisons between different temporal relationships of different sequential patterns. For example, the temporal relationship comparison module 5-229 may compare a first temporal relationship between a first subjective user state and a first objective occurrence of a first sequential pattern with a second temporal relationship between a second subjective user state and a second objective occurrence of a second sequential pattern in order to determine whether the first temporal relationship at least substantially matches the second temporal relationship.

For example, suppose in the above example the first user 5-20a eating at the particular restaurant (e.g., first objective occurrence) and the subsequent stomach ache (e.g., first subjective user state) represents a first sequential pattern while the second user 5-20b eating at the same restaurant (e.g., second objective occurrence) and the subsequent stomach ache (e.g., second subjective user state) represents a second sequential pattern. In this example, the occurrence of the stomach ache after (rather than before or concurrently) eating at the particular restaurant by the first user 5-20a represents a first temporal relationship associated with the first sequential pattern while the occurrence of a second stomach ache after (rather than before or concurrently) eating at the same restaurant by the second user 5-20b represents a second temporal relationship associated with the second sequential pattern. Under such circumstances, the temporal relationship comparison module 5-229 may compare the first temporal relationship to the second temporal relationship in order to determine whether the first temporal relationship and the second temporal relationship at least substantially match (e.g., stomach aches in both temporal relationships occurring after eating at the same restaurant). Such a match may result in the inference that a stomach ache is associated with eating at the particular restaurant.

In some embodiments, the correlation module 5-106 may include a historical data referencing module 5-230. For these embodiments, the historical data referencing module 5-230 may be employed in order to facilitate the correlation of the subjective user state data 5-60 with the objective occurrence data 5-70*. For example, in some implementations, the historical data referencing module 5-230 may be configured to reference historical data 5-72, which may be stored in a memory 5-140, in order to facilitate in determining sequential patterns.

For example, in various implementations, the historical data 5-72 that may be referenced may include, for example, general population trends (e.g., people having a tendency to have a hangover after drinking or ibuprofen being more effective than aspirin for toothaches in the general population), medical information such as genetic, metabolome, or proteome information related to a user 5-20* (e.g., genetic information of the user 5-20* indicating that the user 5-20* is susceptible to a particular subjective user state in response to occurrence of a particular objective occurrence), or historical sequential patterns such as known sequential patterns of the general population or of one or more users 5-20* (e.g., people tending to have difficulty sleeping within five hours after consumption of coffee). In some instances, such historical data 5-72 may be useful in associating one or more subjective user states with one or more objective occurrences as represented by, for example, a sequential pattern.

In some embodiments, the correlation module 5-106 may include a strength of correlation determination module 5-231 for determining a strength of correlation between subjective user state data 5-60 and objective occurrence data 5-70*. In some implementations, the strength of correlation may be determined based, at least in part, on the results provided by the other sub-modules of the correlation module 5-106 (e.g., the sequential pattern determination module 5-220, the sequential pattern comparison module 5-224, and their sub-modules).

FIG. 5-2d illustrates particular implementations of the presentation module 5-108 of the computing device 5-10 of FIG. 5-1b. In various implementations, the presentation module 5-108 may be configured to present one or more results of the correlation operations performed by the correlation module 5-106. In some embodiments, the presentation of the one or more results of the correlation operations may be by transmitting the results via a network interface 5-120 or by indicating the results via a user interface 5-122. The one or more results of the correlation operations may be presented in a variety of different forms in various alternative embodiments. For example, in some implementations this may entail the presentation module 5-108 presenting to the user 5-20* an indication of a sequential relationship between a subjective user state and an objective occurrence associated with a user 5-20* (e.g., “whenever you eat a banana, you have a stomach ache”). In alternative implementations, other ways of presenting the results of the correlation may be employed. For example, in various alternative implementations, a notification may be provided to notify past tendencies or patterns associated with a user 5-20*. In some implementations, a notification of a possible future outcome may be provided. In other implementations, a recommendation for a future course of action based on past patterns may be provided. These and other ways of presenting the correlation results will be described in the processes and operations to be described herein.

In various implementations, the presentation module 5-108 may include a network interface transmission module 5-232 for transmitting one or more results of the correlation performed by the correlation module 5-106. For example, in the case where the computing device 5-10 is a server, the network interface transmission module 5-232 may be configured to transmit to one or more users 5-20* or to a third party (e.g., third party sources 5-50) the one or more results of the correlation performed by the correlation module 5-106 via a network interface 5-120.

In the same or different implementations, the presentation module 5-108 may include a user interface indication module 5-233 for indicating via a user interface 5-122 the one or more results of the correlation operations performed by the correlation module 5-106. For example, in the case where the computing device 5-10 is a local device, the user interface indication module 5-233 may be configured to indicate, via user interface 5-122 such as a display monitor and/or an audio system, the one or more results of the correlation performed by the correlation module 5-106.

In some implementations, the presentation module 5-108 may include a sequential relationship presentation module 5-234 configured to present an indication of a sequential relationship between at least one subjective user state and at least one objective occurrence. In some implementations, the presentation module 5-108 may include a prediction presentation module 5-236 configured to present a prediction of a future subjective user state associated with a user 5-20* resulting from a future objective occurrence. In the same or different implementations, the prediction presentation module 5-236 may also be designed to present a prediction of a future subjective user state associated with a user 5-20* resulting from a past objective occurrence. In some implementations, the presentation module 5-108 may include a past presentation module 5-238 that is designed to present a past subjective user state associated with a user 5-20* in connection with a past objective occurrence.

In some implementations, the presentation module 5-108 may include a recommendation module 5-240 that is configured to present a recommendation for a future action based, at least in part, on the results of a correlation of the subjective user state data 5-60 with the objective occurrence data 5-70* performed by the correlation module 5-106. In certain implementations, the recommendation module 5-240 may further include a justification module 5-242 for presenting a justification for the recommendation presented by the recommendation module 5-240. In some implementations, the presentation module 5-108 may include a strength of correlation presentation module 5-244 for presenting an indication of a strength of correlation between subjective user state data 5-60 and objective occurrence data 5-70*.

As will be further described herein, in some embodiments, the presentation module 5-108 may be prompted to present the one or more results of a correlation operation performed by the correlation module 5-106 in response to a reporting of one or more events, objective occurrences, and/or subjective user states.

As briefly described earlier, in various embodiments, the computing device 5-10 may include a network interface 5-120 that may facilitate in communicating with a remotely located user 5-20* and/or one or more third parties. For example, in embodiments whereby the computing device 5-10 is a server, the computing device 5-10 may include a network interface 5-120 that may be configured to receive from a user 5-20* subjective user state data 5-60. In some embodiments, objective occurrence data 5-70a, 5-70b, or 5-70c may also be received through the network interface 5-120. Examples of a network interface 5-120 includes, for example, a network interface card (NIC).

The computing device 5-10, in various embodiments, may also include a memory 5-140 for storing various data. For example, in some embodiments, memory 5-140 may be employed in order to store subjective user state data 5-60 of one or more users 5-20* including data that may indicate one or more past subjective user states of one or more users 5-20* and objective occurrence data 5-70* including data that may indicate one or more past objective occurrences. In some embodiments, memory 5-140 may store historical data 5-72 such as historical medical data of one or more users 5-20* (e.g., genetic, metoblome, proteome information), population trends, historical sequential patterns derived from general population, and so forth.

In various embodiments, the computing device 5-10 may include a user interface 5-122 to communicate directly with a user 5-20b. For example, in embodiments in which the computing device 5-10 is a local device, the user interface 5-122 may be configured to directly receive from the user 5-20b subjective user state data 5-60. The user interface 5-122 may include, for example, one or more of a display monitor, a touch screen, a key board, a key pad, a mouse, an audio system, an imaging system including a digital or video camera, and/or other user interface devices.

FIG. 5-2e illustrates particular implementations of the one or more applications 5-126 of FIG. 5-1b. For these implementations, the one or more applications 5-126 may include, for example, communication applications such as a text messaging application and/or an audio messaging application including a voice recognition system application. In some implementations, the one or more applications 5-126 may include a web 2.0 application 5-250 to facilitate communication via, for example, the World Wide Web.

The functional roles of the various components, modules, and sub-modules of the computing device 5-10 presented thus far will be described in greater detail with respect to the processes and operations to be described herein. Note that the subjective user state data 5-60 may be in a variety of forms including, for example, text messages (e.g., blog entries, microblog entries, instant messages, email messages, and so forth), audio messages, and/or image files (e.g., an image capturing user's facial expression or user gestures).

FIG. 5-3 illustrates an operational flow 5-300 representing example operations related to acquisition and correlation of subjective user state data including data indicating incidences of subjective user states associated with multiple users 5-20* and objective occurrence data 5-70* including data indicating incidences of one or more objective occurrences in accordance with various embodiments. In some embodiments, the operational flow 5-300 may be executed by, for example, the computing device 5-10 of FIG. 5-1b.

In FIG. 5-3 and in the following figures that include various examples of operational flows, discussions and explanations may be provided with respect to the above-described exemplary environment of FIGS. 5-1a and 5-1b, and/or with respect to other examples (e.g., as provided in FIGS. 5-2a to 5-2e) and contexts. However, it should be understood that the operational flows may be executed in a number of other environments and contexts, and/or in modified versions of FIGS. 5-1a, 5-1b, and 5-2a to 5-2e. Also, although the various operational flows are presented in the sequence(s) illustrated, it should be understood that the various operations may be performed in other orders than those which are illustrated, or may be performed concurrently.

Further, in FIG. 5-3 and in following figures, various operations may be depicted in a box-within-a-box manner. Such depictions may indicate that an operation in an internal box may comprise an optional example embodiment of the operational step illustrated in one or more external boxes. However, it should be understood that internal box operations may be viewed as independent operations separate from any associated external boxes and may be performed in any sequence with respect to all other illustrated operations, or may be performed concurrently.

In any event, after a start operation, the operational flow 5-300 may move to a subjective user state data acquisition operation 5-302 for acquiring subjective user state data including data indicating incidence of at least a first subjective user state associated with a first user and data indicating incidence of at least a second subjective user state associated with a second user. For instance, the subjective user state data acquisition module 5-102 of the computing device 5-10 of FIG. 5-1b acquiring (e.g., receiving via network interface 5-120 or via user interface 5-122 or retrieving from memory 5-140) subjective user state data 5-60 including data indicating incidence of at least a first subjective user state 5-60a (e.g., a subjective mental state, a subjective physical state, or a subjective overall state) associated with a first user 5-20a and data indicating incidence of at least a second subjective user state 5-60b associated with a second user 5-20b. Note that and as will be described herein, the first subjective user state associated with the first user 5-20a and the second subjective user state associated with the second user 5-20b may be the same or different subjective user states. For example, both the first user 5-20a and the second user 5-20b feeling “sad.” Alternatively, the first subjective user state associated with the first user 5-20a may be the first user 5-20a feeling “happy,” while the second subjective user state associated with the second user 5-20b may be the second user 5-20b feeling “sad” or some other subjective user state.

Operational flow 5-300 may also include an objective occurrence data acquisition operation 5-304 for acquiring objective occurrence data including data indicating incidence of at least a first objective occurrence and data indicating incidence of at least a second objective occurrence. For instance, the objective occurrence data acquisition module 5-104 of the computing device 5-10 acquiring, via the network interface 5-120 or via the user interface 5-122, objective occurrence data 5-70* including data indicating incidence of at least one objective occurrence (e.g., ingestion of a food, medicine, or nutraceutical by the first user 5-20a) and data indicating incidence of at least a second objective occurrence (e.g., ingestion of a food, medicine, or nutraceutical by the second user 5-20b).

In various implementations, and as will be further described herein, the first objective occurrence and the second objective occurrence may be related to the same event (e.g., both the first and the second objective occurrence relating to the same “cloudy weather” in Seattle on Mar. 3, 2010), related to the same types of events (e.g., the first objective occurrence relating to “cloudy weather” in Seattle on Mar. 3, 2010 while the second objective occurrence relating to “cloudy weather” in Los Angeles on Feb. 20, 2010), or related to different types of events (e.g., the first objective occurrence relating to “cloudy” weather” in Seattle on Mar. 3, 2010 while the second objective occurrence relating to “sunny weather” in Los Angeles on Feb. 20, 2010).

Again, note that “*” represents a wildcard. Thus, in the above, objective occurrence data 5-70* may represent objective occurrence data 5-70a, objective occurrence data 5-70b, and/or objective occurrence data 5-70c. As those skilled in the art will recognize, the subjective user state data acquisition operation 5-302 does not have to be performed prior to the objective occurrence data acquisition operation 5-304 and may be performed subsequent to the performance of the objective occurrence data acquisition operation 5-304 or may be performed concurrently with the objective occurrence data acquisition operation 5-304.

Finally, operational flow 5-300 may further include a correlation operation 5-306 for correlating the subjective user state data with the objective occurrence data. For instance, the correlation module 5-106 of the computing device 5-10 correlating (e.g., linking or determining a relationship) the subjective user state data 5-60 with the objective occurrence data 5-70*.

In various implementations, the subjective user state data acquisition operation 5-302 may include one or more additional operations as illustrated in FIGS. 5-4a, 5-4b, 5-4c, 5-4d, 5-4e, and 5-4f. For example, in some implementations the subjective user state data acquisition operation 5-302 may include a reception operation 5-402 for receiving one, or both, of the data indicating incidence of at least a first subjective user state and the data indicating incidence of at least a second subjective user state as depicted in FIGS. 5-4a and 5-4b. For instance, the reception module 5-202 (see FIG. 5-2a) of the computing device 5-10 receiving (e.g., via network interface 5-120 and/or via the user interface 5-122) one, or both, of the data indicating incidence of at least a first subjective user state 5-60a (e.g., a first user 5-20a feeling depressed) and the data indicating incidence of at least a second subjective user state 5-60b (e.g., a second user 5-20b also feeling depressed or alternatively, feeling happy or feeling some other way).

The reception operation 5-402 may, in turn, further include one or more additional operations. For example, in some implementations, the reception operation 5-402 may include an operation 5-404 for receiving one, or both, of the data indicating incidence of at least a first subjective user state and the data indicating incidence of at least a second subjective user state via a user interface as depicted in FIG. 5-4a. For instance, the reception module 5-202 of the computing device 5-10 receiving one, or both, of the data indicating incidence of at least a first subjective user state 5-60a and the data indicating incidence of at least a second subjective user state 5-60b via a user interface 5-122 (e.g., a keypad, a keyboard, a display monitor, a touchscreen, a mouse, an audio system including a microphone, an image capturing system including a video or digital camera, and/or other interface devices).

In some implementations, the reception operation 5-402 may include an operation 5-406 for receiving one, or both, of the data indicating incidence of at least a first subjective user state and the data indicating incidence of at least a second subjective user state via a network interface as depicted in FIG. 5-4a. For instance, the reception module 5-202 of the computing device 5-10 receiving one, or both, of the data indicating incidence of at least a first subjective user state 5-60a and the data indicating incidence of at least a second subjective user state 5-60b via a network interface 5-120 (e.g., a NIC).

The subjective user state data 5-60 including the data indicating incidence of at a least first subjective user state 5-60a and the data indicating incidence of at least a second subjective user state 5-60b may be received in various forms. For example, in some implementations, the reception operation 5-402 may include an operation 5-408 for receiving one, or both, of the data indicating incidence of at least a first subjective user state and the data indicating incidence of at least a second subjective user state via one or more electronic messages as depicted in FIG. 5-4a. For instance, the electronic message reception module 5-204 of the computing device 5-10 receiving one, or both, of the data indicating incidence of at least a first subjective user state 5-60a (e.g., subjective mental state such as feelings of happiness, sadness, anger, frustration, mental fatigue, drowsiness, alertness, and so forth) and the data indicating incidence of at least a second subjective user state 5-60b (e.g., subjective mental state such as feelings of happiness, sadness, anger, frustration, mental fatigue, drowsiness, alertness, and so forth) via one or more electronic messages (e.g., email, IM, or text message).

In some implementations, the reception operation 5-402 may include an operation 5-410 for receiving one, or both, of the data indicating incidence of at least a first subjective user state and the data indicating incidence of at least a second subjective user state via one or more blog entries as depicted in FIG. 5-4a. For instance, the blog entry reception module 5-205 of the computing device 5-10 receiving one, or both, of the data indicating incidence of at least a first subjective user state 5-60a (e.g., subjective physical state such as physical exhaustion, physical pain such as back pain or toothache, upset stomach, blurry vision, and so forth) and the data indicating incidence of at least a second subjective user state 5-60b (e.g., subjective physical state such as physical exhaustion, physical pain such as back pain or toothache, upset stomach, blurry vision, and so forth) via one or more blog entries (e.g., one or more microblog entries).

In some implementations, operation 5-402 may include an operation 5-412 for receiving one, or both, of the data indicating incidence of at least a first subjective user state and the data indicating incidence of at least a second subjective user state via one or more status reports as depicted in FIG. 5-4a. For instance, the status report reception module 5-206 of the computing device 5-10 receiving one, or both, of the data indicating incidence of at least a first subjective user state 5-60a (e.g., subjective overall state of the first user 5-20a such as “good,” “bad,” “well,” “exhausted,” and so forth) and the data indicating incidence of at least a second subjective user state 5-60b (e.g., subjective overall state of the second user 5-20b such as “good,” “bad,” “well,” “exhausted,” and so forth) via one or more status reports (e.g., one or more social networking status reports).

In some implementations, the reception operation 5-402 may include an operation 5-414 for receiving one, or both, of the data indicating incidence of at least a first subjective user state and the data indicating incidence of at least a second subjective user state via one or more text entries as depicted in FIG. 5-4a. For instance, the text entry reception module 5-207 of the computing device 5-10 receiving one, or both, of the data indicating incidence of at least a first subjective user state 5-60a and the data (e.g., a subjective mental state, a subjective physical state, or a subjective overall state) indicating incidence of at least a second subjective user state 5-60b (e.g., a subjective mental state, a subjective physical state, or a subjective overall state) via one or more text entries (e.g., text data as provided through one or more mobile devices 5-30* or through a user interface 5-122).

In some implementations, the reception operation 5-402 may include an operation 5-416 for receiving one, or both, of the data indicating incidence of at least a first subjective user state and the data indicating incidence of at least a second subjective user state via one or more audio entries as depicted in FIG. 5-4a. For instance, the audio entry reception module 5-208 of the computing device 5-10 receiving one, or both, of the data indicating incidence of at least a first subjective user state 5-60a (e.g., a subjective mental state, a subjective physical state, or a subjective overall state associated with the first user 5-20a) and the data indicating incidence of at least a second subjective user state 5-60b (e.g., a subjective mental state, a subjective physical state, or a subjective overall state associated with the second user 5-20b) via one or more audio entries (e.g., audio recording made via one or more mobile devices 5-30* or via the user interface 5-122).

In some implementations, the reception operation 5-402 may include an operation 5-418 for receiving one, or both, of the data indicating incidence of at least a first subjective user state and the data indicating incidence of at least a second subjective user state via one or more image entries as depicted in FIG. 5-4b. For instance, the image entry reception module 5-209 of the computing device 5-10 receiving one, or both, of the data indicating incidence of at least a first subjective user state 5-60a (e.g., a subjective mental state, a subjective physical state, or a subjective overall state associated with the first user 5-20a) and the data indicating incidence of at least a second subjective user state 5-60b (e.g., a subjective mental state, a subjective physical state, or a subjective overall state associated with the second user 5-20b) via one or more image entries (e.g., image data obtained via one or more mobile devices 5-30* or via the user interface 5-122).

The subjective user state data 5-60 may be obtained from various alternative and/or complementary sources. For example, in some implementations, the reception operation 5-402 may include an operation 5-420 for receiving one, or both, of the data indicating incidence of at least a first subjective user state and the data indicating incidence of at least a second subjective user state from one, or both, the first user and the second user as depicted in FIG. 5-4b. For instance, the reception module 5-202 of the computing device 5-10 receiving, via the network interface 5-120 or via the user interface 5-122, one or both, of the data indicating incidence of at least a first subjective user state 5-60a (e.g., a subjective mental state, a subjective physical state, or a subjective overall state associated with the first user 5-20a) and the data indicating incidence of at least a second subjective user state 5-60b (e.g., a subjective mental state, a subjective physical state, or a subjective overall state associated with the second user 5-20b) from one, or both, the first user 5-20a and the second user 5-20b.

In some implementations, the reception operation 5-402 may include an operation 5-422 for receiving one, or both, of the data indicating incidence of at least a first subjective user state and the data indicating incidence of at least a second subjective user state from one or more third party sources as depicted in FIG. 5-4b. For instance, the reception module 5-202 of the computing device 5-10 receiving, via the network interface 5-120 or via the user interface 5-122, one, or both, of the data indicating incidence of at least a first subjective user state 5-60a (e.g., a subjective mental state, a subjective physical state, or a subjective overall state associated with the first user 5-20a) and the data indicating incidence of at least a second subjective user state 5-60b (e.g., a subjective mental state, a subjective physical state, or a subjective overall state associated with the second user 5-20b) from one or more third party sources 5-50 (e.g., network service providers through network servers).

In some implementations, the reception operation 5-402 may include an operation 5-424 for receiving data indicating a selection made by the first user, the selection indicating the first subjective user state selected from a plurality of indicated alternative subjective user states as depicted in FIG. 5-4b. For instance, the reception module 5-202 of the computing device 5-10 receiving, via the network interface 5-120 or via the user interface 5-122, data indicating a selection (e.g., a selection made via a mobile device 5-30a or via a user interface 5-122) made by the first user 5-20a, the selection indicating the first subjective user state (e.g., “feeling good”) selected from a plurality of indicated alternative subjective user states (e.g., “feeling good,” “feeling bad,” “feeling tired,” “having a headache,” and so forth).

In some implementations, operation 5-424 may further include an operation 5-426 for receiving data indicating a selection made by the first user, the selection indicating the first subjective user state selected from a plurality of indicated alternative contrasting subjective user states as depicted in FIG. 5-4b. For instance, the reception module 5-202 of the computing device 5-10 receiving, via the network interface 5-120 or via the user interface 5-122, data indicating a selection (e.g., “feeling very good”) made by the first user 5-20a, the selection indicating the first subjective user state selected from a plurality of indicated alternative contrasting subjective user states (e.g., “feeling very good,” “feeling somewhat good,” “feeling indifferent,” “feeling a little bad,” and so forth).

In some implementations, operation 5-424 may further include an operation 5-428 for receiving data indicating a selection made by the second user, the selection indicating the second subjective user state selected from a plurality of indicated alternative subjective user states as depicted in FIG. 5-4b. For instance, the reception module 5-202 of the computing device 5-10 receiving, via the network interface 5-120 or via the user interface 5-122, data indicating a selection made by the second user 5-20b, the selection indicating the second subjective user state (e.g., “feeling good”) selected from a plurality of indicated alternative subjective user states (e.g., “feeling good,” “feeling bad,” “feeling tired,” “having a headache,” and so forth).

In some implementations, the subjective user state data acquisition operation 5-302 of FIG. 5-3 may include an operation 5-430 for acquiring data indicating incidence of a first subjective mental state associated with the first user as depicted in FIG. 5-4c. For instance, the subjective user state data acquisition module 5-102 of the computing device 5-10 acquiring (e.g., receiving via a network interface 5-120 or via a user interface 5-122, or by retrieving from memory 5-140) data indicating incidence of a first subjective mental state (e.g., sadness, happiness, alertness or lack of alertness, anger, frustration, envy, hatred, disgust, and so forth) associated with the first user 5-20a.

In various alternative implementations, operation 5-430 may further include an operation 5-432 for acquiring data indicating incidence of a second subjective mental state associated with the second user as depicted in FIG. 5-4c. For instance, the subjective user state data acquisition module 5-102 of the computing device 5-10 acquiring (e.g., receiving via a network interface 5-120 or via a user interface 5-122, or by retrieving from memory 5-140) data indicating incidence of a second subjective mental state (e.g., sadness, happiness, alertness or lack of alertness, anger, frustration, envy, hatred, disgust, and so forth) associated with the second user 5-20b.

Operation 5-432, in turn, may further include one or more additional operations in some implementations. For example, in some implementations, operation 5-432 may include an operation 5-434 for acquiring data indicating incidence of a second subjective mental state associated with the second user, the second subjective mental state of the second user being a subjective mental state that is similar or same as the first subjective mental state of the first user as depicted in FIG. 5-4c. For instance, the subjective user state data acquisition module 5-102 of the computing device 5-10 acquiring (e.g., receiving via a network interface 5-120 or via a user interface 5-122, or by retrieving from memory 5-140) data indicating incidence of a second subjective mental state (e.g., “exhausted”) associated with the second user 5-20b, the second subjective mental state of the second user 5-20b being a subjective mental state that is similar or same as the first subjective mental state (e.g., “fatigued”) of the first user 5-20a.

In some implementations, operation 5-432 may include an operation 5-436 for acquiring data indicating incidence of a second subjective mental state associated with the second user, the second subjective mental state of the second user being a contrasting subjective mental state from the first subjective mental state of the first user as depicted in FIG. 5-4c. For instance, the subjective user state data acquisition module 5-102 of the computing device 5-10 acquiring (e.g., receiving via a network interface 5-120 or via a user interface 5-122, or by retrieving from memory 5-140) data indicating incidence of a second subjective mental state (e.g., “slightly happy” or “sad”) associated with the second user 5-20b, the second subjective mental state of the second user 5-20b being a contrasting subjective mental state from the first subjective mental state (e.g., “extremely happy”) of the first user 5-20a.

In some implementations, the subjective user state data acquisition operation 5-302 of FIG. 5-3 may include an operation 5-438 for acquiring data indicating incidence of a first subjective physical state associated with the first user as depicted in FIG. 5-4c. For instance, the subjective user state data acquisition module 5-102 of the computing device 5-10 acquiring (e.g., receiving via a network interface 5-120 or via a user interface 5-122, or by retrieving from memory 5-140) data indicating incidence of a first subjective physical state (e.g., blurry vision, physical pain such as backache or headache, upset stomach, physical exhaustion, and so forth) associated with the first user 5-20a.

In various implementations, operation 5-438 may further include one or more additional operations. For example, in some implementations, operation 5-438 may include an operation 5-440 for acquiring data indicating incidence of a second subjective physical state associated with the second user as depicted in FIG. 5-4c. For instance, the subjective user state data acquisition module 5-102 of the computing device 5-10 acquiring (e.g., receiving via a network interface 5-120 or via a user interface 5-122, or by retrieving from memory 5-140) data indicating incidence of a second subjective physical state (e.g., blurry vision, physical pain such as backache or headache, upset stomach, physical exhaustion, and so forth) associated with the second user 5-20b.

In some implementations, operation 5-440 may further include an operation 5-442 for acquiring data indicating incidence of a second subjective physical state associated with the second user, the second subjective physical state of the second user being a subjective physical state that is similar or same as the first subjective physical state of the first user as depicted in FIG. 5-4c. For instance, the subjective user state data acquisition module 5-102 of the computing device 5-10 acquiring (e.g., receiving via a network interface 5-120 or via a user interface 5-122, or by retrieving from memory 5-140) data indicating incidence of a second subjective physical state (e.g., mild headache) associated with the second user 5-20b, the second subjective physical state of the second user 5-20b being a subjective physical state that is similar or same as the first subjective physical state (e.g., slight headache) of the first user 5-20a.

In some implementations, operation 5-440 may include an operation 5-444 for acquiring data indicating incidence of a second subjective physical state associated with the second user, the second subjective physical state of the second user being a contrasting subjective physical state from the first subjective physical state of the first user as depicted in FIG. 5-4c. For instance, the subjective user state data acquisition module 5-102 of the computing device 5-10 acquiring (e.g., receiving via a network interface 5-120 or via a user interface 5-122, or by retrieving from memory 5-140) data indicating incidence of a second subjective physical state (e.g., slight headache or no headache) associated with the second user 5-20b, the second subjective physical state of the second user 5-20b being a contrasting subjective physical state from the first subjective physical state (e.g., migraine headache) of the first user 5-20a.

In some implementations, the subjective user state data acquisition operation 5-302 of FIG. 5-3 may include an operation 5-446 for acquiring data indicating incidence of a first subjective overall state associated with the first user as depicted in FIG. 5-4d. For instance, the subjective user state data acquisition module 5-102 of the computing device 5-10 acquiring (e.g., receiving via a network interface 5-120 or via a user interface 5-122, or by retrieving from memory 5-140) data indicating incidence of a first subjective overall state (e.g., good, bad, wellness, hangover, fatigue, nausea, and so forth) associated with the first user 5-20a. Note that a subjective overall state, as used herein, may be in reference to any subjective user state that may not fit neatly into the categories of subjective mental state or subjective physical state.

In various implementations, operation 5-446 may further include one or more additional operations. For example, in some implementations, operation 5-446 may include an operation 5-448 for acquiring data indicating incidence of a second subjective overall state associated with the second user as depicted in FIG. 5-4d. For instance, the subjective user state data acquisition module 5-102 of the computing device 5-10 acquiring (e.g., receiving via a network interface 5-120 or via a user interface 5-122, or by retrieving from memory 5-140) data indicating incidence of a second subjective overall state (e.g., good, bad, wellness, hangover, fatigue, nausea, and so forth) associated with the second user 5-20b.

In some implementations, operation 5-448 may further include an operation 5-450 for acquiring data indicating incidence of a second subjective overall state associated with the second user, the second subjective overall state of the second user being a subjective overall state that is similar or same as the first subjective overall state of the first user as depicted in FIG. 5-4d. For instance, the subjective user state data acquisition module 5-102 of the computing device 5-10 acquiring (e.g., receiving via a network interface 5-120 or via a user interface 5-122, or by retrieving from memory 5-140) data indicating incidence of a second subjective overall state (e.g., “excellent”) associated with the second user 5-20b, the second subjective overall state of the second user 5-20b being a subjective overall state that is similar or same as the first subjective overall state (e.g., “excellent” or “great”) of the first user 5-20a.

In some implementations, operation 5-448 may include an operation 5-452 for acquiring data indicating incidence of a second subjective overall state associated with the second user, the second subjective overall state of the second user being a contrasting subjective overall state from the first subjective overall state of the first user as depicted in FIG. 5-4d. For instance, the subjective user state data acquisition module 5-102 of the computing device 5-10 acquiring (e.g., receiving via a network interface 5-120 or via a user interface 5-122, or by retrieving from memory 5-140) data indicating incidence of a second subjective overall state (e.g., “bad” or “horrible”) associated with the second user 5-20b, the second subjective overall state of the second user 5-20b being a contrasting subjective overall state from the first subjective overall state (e.g., “excellent”) of the first user 5-20a.

In some implementations, the subjective user state data acquisition operation 5-302 of FIG. 5-3 may include an operation 5-454 for acquiring data indicating a second subjective user state associated with the second user that is at least proximately equivalent to the first subjective user state associated with the first user as depicted in FIG. 5-4d. For instance, the subjective user state data acquisition module 5-102 of the computing device 5-10 acquiring (e.g., receiving via a network interface 5-120 or via a user interface 5-122, or by retrieving from memory 5-140) data indicating a second subjective user state (e.g., very sad) associated with the second user 5-20b that is at least proximately equivalent to the first subjective user state (e.g., extremely sad) associated with the first user 5-20a.

In various implementations, operation 5-454 may further include one or more additional operations. For example, in some implementations, operation 5-454 may include an operation 5-456 for acquiring data indicating a second subjective user state associated with the second user that is at least approximately equivalent in meaning to the first subjective user state associated with the first user as depicted in FIG. 5-4d. For instance, the subjective user state data acquisition module 5-102 of the computing device 5-10 acquiring (e.g., receiving via a network interface 5-120 or via a user interface 5-122, or by retrieving from memory 5-140) data indicating a second subjective user state (e.g., gloomy) associated with the second user 5-20b that is at least approximately equivalent in meaning to the first subjective user state (e.g., depressed) associated with the first user 5-20a.

In some implementations, operation 5-454 may include an operation 5-458 for acquiring data indicating a second subjective user state associated with the second user that is same as the first subjective user state associated with the first user as depicted in FIG. 5-4d. For instance, the subjective user state data acquisition module 5-102 of the computing device 5-10 acquiring (e.g., receiving via a network interface 5-120 or via a user interface 5-122, or by retrieving from memory 5-140) data indicating a second subjective user state (e.g., mentally exhausted) associated with the second user 5-20b that is same as the first subjective user state (e.g., mentally exhausted) associated with the first user 5-20a.

In some implementations, the subjective user state data acquisition operation 5-302 of FIG. 5-3 may include an operation 5-460 for acquiring data indicating a second subjective user state associated with the second user that is a contrasting subjective user state from the first subjective user state associated with the first user as depicted in FIG. 5-4e. For instance, the subjective user state data acquisition module 5-102 of the computing device 5-10 acquiring (e.g., receiving via a network interface 5-120 or via a user interface 5-122, or by retrieving from memory 5-140) data indicating a second subjective user state (e.g., “good”) associated with the second user 5-20b that is a contrasting subjective user state from the first subjective user state (e.g., “bad”) associated with the first user 5-20a. In some implementations, contrasting subjective user states may be in reference to subjective user states that may be variations of the same subjective user state type (e.g., subjective mental states such as different levels of happiness, which may also include different levels of sadness).

In some implementations, the subjective user state data acquisition operation 5-302 may include an operation 5-462 for acquiring a time stamp associated with the at least first subjective user state associated with the first user as depicted in FIG. 5-4e. For instance, the time stamp acquisition module 5-210 of the computing device 5-10 acquiring (e.g., receiving via a network interface 5-120 or via a user interface 5-122, or by self-generating) a time stamp (e.g., 10 PM Aug. 4, 2009) associated with the at least first subjective user state (e.g., very bad upset stomach) associated with the first user 5-20a.

Operation 5-462, in turn, may further include an operation 5-464 for acquiring another time stamp associated with the at least second subjective user state associated with the second user as depicted in FIG. 5-4e. For instance, the time stamp acquisition module 5-210 of the computing device 5-10 acquiring (e.g., receiving via a network interface 5-120 or via a user interface 5-122, or by self-generating) another time stamp (e.g., 8 PM Aug. 12, 2009) associated with the at least second subjective user state (e.g., a slight upset stomach) associated with the second user 5-20b.

In some implementations, the subjective user state data acquisition operation 5-302 may include an operation 5-466 for acquiring an indication of a time interval associated with the at least first subjective user state associated with the first user as depicted in FIG. 5-4e. For instance, the time interval indication acquisition module 5-211 of the computing device 5-10 acquiring (e.g., receiving via a network interface 5-120 or via a user interface 5-122, or by self-generating) an indication of a time interval (e.g., 8 AM to 10 AM Jul. 24, 2009) associated with the at least first subjective user state (e.g., feeling tired) associated with the first user 5-20a.

Operation 5-466, in turn, may further include an operation 5-468 for acquiring another indication of a time interval associated with the at least second subjective user state associated with the second user as depicted in FIG. 5-4e. For instance, the time interval indication acquisition module 5-211 of the computing device 5-10 acquiring (e.g., receiving via a network interface 5-120 or via a user interface 5-122, or by self-generating) another indication of a time interval (e.g., 2 PM to 8 PM Jul. 24, 2009) associated with the at least second subjective user state (e.g., feeling tired) associated with the second user 5-20b.

In some implementations, the subjective user state data acquisition operation 5-302 may include an operation 5-470 for acquiring an indication of a temporal relationship between the at least first subjective user state and the at least first objective occurrence as depicted in FIG. 5-4e. For instance, the temporal relationship indication acquisition module 5-212 acquiring (e.g., receiving via a network interface 5-120 or via a user interface 5-122, or by self-generating) an indication of a temporal relationship (e.g., before, after, or at least partially concurrently occurring) between the at least first subjective user state (e.g., easing of a headache) and the at least first objective occurrence (e.g., ingestion of aspirin).

Operation 5-470, in turn, may further include an operation 5-472 for acquiring an indication of a temporal relationship between the at least second subjective user state and the at least second objective occurrence as depicted in FIG. 5-4e. For instance, the temporal relationship indication acquisition module 5-212 acquiring (e.g., receiving via a network interface 5-120 or via a user interface 5-122, or by self-generating) an indication of a temporal relationship between the at least second subjective user state (e.g., easing of a headache) and the at least second objective occurrence (e.g., ingestion of aspirin).

In some implementations, the subjective user state data acquisition operation 5-302 may include an operation 5-474 for soliciting from the first user the data indicating incidence of at least a first subjective user state associated with the first user as depicted in FIG. 5-4e. For instance, the solicitation module 5-213 soliciting from the first user 5-20a (e.g., transmitting via a network interface 5-120 or indicating via a user interface 5-122) a request to be provided with the data indicating incidence of at least a first subjective user state 5-60a associated with the first user 5-20a. In some implementations, the solicitation of the at least first subjective user state may involve requesting the user 5-20a to select at least one subjective user state from a plurality of alternative subjective user states.

Operation 5-474, in turn, may further include an operation 5-476 for transmitting or indicating to the first user a request for the data indicating incidence of at least a first subjective user state associated with the first user as depicted in FIG. 5-4e. For instance, the request transmit/indicate module 5-214 (which may be designed to transmit a request via a network interface 5-120 and/or to indicate a request via a user interface 5-122) of the computing device 5-10 transmitting or indicating to the first user 5-20a a request for the data indicating incidence of at least a first subjective user state 5-60a associated with the first user 5-20a.

In some implementations, the subjective user state data acquisition operation 5-302 may include an operation 5-478 for acquiring data indicating incidence of at least a third subjective user state associated with a third user as depicted in FIG. 5-4e. For instance, the subjective user state data acquisition module 5-102 of the computing device 5-10 acquiring (e.g., receiving via a network interface 5-120 or via a user interface 5-122, or retrieving from memory 5-140) data indicating incidence of at least a third subjective user state 5-60c associated with a third user 5-20c.

Operation 5-478, in turn, may further include an operation 5-480 for acquiring data indicating incidence of at least a fourth subjective user state associated with a fourth user as depicted in FIG. 5-4e. For instance, the subjective user state data acquisition module 5-102 of the computing device 5-10 acquiring (e.g., receiving via a network interface 5-120 or via a user interface 5-122, or retrieving from memory 5-140) data indicating incidence of at least a fourth subjective user state 5-60d associated with a fourth user 5-20d.

In some implementations, the subjective user state data acquisition operation 5-302 may include an operation 5-482 for acquiring the subjective user state data at a server as depicted in FIG. 5-4f. For instance, when the computing device 5-10 is a network server and is acquiring the subjective user state data 5-60.

In some implementations, the subjective user state data acquisition operation 5-302 may include an operation 5-484 for acquiring the subjective user state data at a handheld device as depicted in FIG. 5-4f. For instance, when the computing device 5-10 is a handheld device such as a mobile phone or a PDA and is acquiring the subjective user state data 5-60.

In some implementations, the subjective user state data acquisition operation 5-302 may include an operation 5-486 for acquiring the subjective user state data at a peer-to-peer network component device as depicted in FIG. 5-4f. For instance, when the computing device 5-10 is a peer-to-peer network component device and is acquiring the subjective user state data 5-60.

In some implementations, the subjective user state data acquisition operation 5-302 may include an operation 5-488 for acquiring the subjective user state data via a Web 2.0 construct as depicted in FIG. 5-4f. For instance, when the computing device 5-10 employs a Web 2.0 application 5-250 in order to acquire the subjective user state data 5-60.

Referring back to FIG. 5-3, the objective occurrence data acquisition operation 5-304 in various embodiments may include one or more additional operations as illustrated in FIGS. 5-5a to 5-5g. For example, in some implementations, the objective occurrence data acquisition operation 5-304 may include a reception operation 5-502 for receiving one, or both, of the data indicating incidence of at least a first objective occurrence and the data indicating incidence of at least a second objective occurrence as depicted in FIG. 5-5a. For instance, the objective occurrence data reception module 5-215 (see FIG. 5-2b) of the computing device 5-10 receiving (e.g., via the network interface 5-120 and/or via the user interface 5-122) one, or both, of the data indicating incidence of at least a first objective occurrence and the data indicating incidence of at least a second objective occurrence.

In various implementations, the reception operation 5-502 may include one or more additional operations. For example, in some implementations the reception operation 5-502 may include an operation 5-504 for receiving one, or both, of the data indicating incidence of at least a first objective occurrence and the data indicating incidence of at least a second objective occurrence via user interface as depicted in FIG. 5-5a. For instance, the objective occurrence data reception module 5-215 of the computing device 5-10 receiving one, or both, of the data indicating incidence of at least a first objective occurrence and the data indicating incidence of at least a second objective occurrence via user interface 5-122.

In some implementations, the reception operation 5-502 may include an operation 5-506 for receiving one, or both, of the data indicating incidence of at least a first objective occurrence and the data indicating incidence of at least a second objective occurrence from at least one of a wireless network or a wired network as depicted in FIG. 5-5a. For instance, the objective occurrence data reception module 5-215 of the computing device 5-10 receiving one, or both, of the data indicating incidence of at least a first objective occurrence (e.g., ingestion of a medicine, a food item, or a nutraceutical by a first user 5-20a) and the data indicating incidence of at least a second objective occurrence (e.g., ingestion of a medicine, a food item, or a nutraceutical by a second user 5-20b) from a wireless and/or wired network 5-40.

In some implementations, the reception operation 5-502 may include an operation 5-508 for receiving one, or both, of the data indicating incidence of at least a first objective occurrence and the data indicating incidence of at least a second objective occurrence via one or more blog entries as depicted in FIG. 5-5a. For instance, the blog entry reception module 5-216 of the computing device 5-10 receiving (e.g., via the network interface 5-120) one, or both, of the data indicating incidence of at least a first objective occurrence (e.g., an activity executed by a first user 5-20a) and the data indicating incidence of at least a second objective occurrence (e.g., an activity executed by a second user 5-20b) via one or more blog entries (e.g., microblog entries).

In some implementations, the reception operation 5-502 may include an operation 5-510 for receiving one, or both, of the data indicating incidence of at least a first objective occurrence and the data indicating incidence of at least a second objective occurrence via one or more status reports as depicted in FIG. 5-5a. For instance, the status report reception module 5-217 of the computing device 5-10 receiving (e.g., via the network interface 5-120) one, or both, of the data indicating incidence of at least a first objective occurrence (e.g., a first external event such as the weather on a particular day at a particular location associated with a first user 5-20a) and the data indicating incidence of at least a second objective occurrence (e.g., a second external event such as the weather on another day at another location associated with a second user 5-20b) via one or more status reports (e.g., social networking status reports).

In some implementations, the reception operation 5-502 may include an operation 5-512 for receiving one, or both, of the data indicating incidence of at least a first objective occurrence and the data indicating incidence of at least a second objective occurrence via a Web 2.0 construct as depicted in FIG. 5-5a. For instance, the objective occurrence data reception module 5-215 of the computing device 5-10 receiving (e.g., via the network interface 5-120) one, or both, of the data indicating incidence of at least a first objective occurrence (e.g., a location of a first user 5-20a) and the data indicating incidence of at least a second objective occurrence (e.g., a location of a second user 5-20b) via a Web 2.0 construct (e.g., Web 2.0 application 5-250).

In some implementations, the reception operation 5-502 may include an operation 5-514 for receiving one, or both, of the data indicating incidence of at least a first objective occurrence and the data indicating incidence of at least a second objective occurrence from one or more sensors as depicted in FIG. 5-5a. For instance, the objective occurrence data reception module 5-215 of the computing device 5-10 receiving (e.g., via the network interface 5-120) one, or both, of the data indicating incidence of at least a first objective occurrence (e.g., an objective physical characteristic of a first user 5-20a) and the data indicating incidence of at least a second objective occurrence (e.g., an objective physical characteristic of a second user 5-20b) from one or more sensors 5-35.

In various implementations, the reception operation 5-502 may include an operation 5-516 for receiving the data indicating incidence of at least a first objective occurrence from the first user as depicted in FIG. 5-5b. For instance, the objective occurrence data reception module 5-215 of the computing device 5-10 receiving (e.g., via the network interface 5-120 or via the user interface 5-122) the data indicating incidence of at least a first objective occurrence (e.g., a social or professional activity executed by the first user 5-20a) from the first user 5-20a.

In some implementations, operation 5-516 may further include an operation 5-518 for receiving the data indicating incidence of at least a second objective occurrence from the second user as depicted in FIG. 5-5b. For instance, the objective occurrence data reception module 5-215 of the computing device 5-10 receiving (e.g., via the network interface 5-120 or via the user interface 5-122) the data indicating incidence of at least a second objective occurrence (e.g., a social or professional activity executed by the second user 5-20b) from the second user 5-20b.

In some implementations, the reception operation 5-502 may include an operation 5-520 for receiving one, or both, of the data indicating incidence of at least a first objective occurrence and the data indicating incidence of at least a second objective occurrence from one or more third party sources as depicted in FIG. 5-5b. For instance, the objective occurrence data reception module 5-215 of the computing device 5-10 receiving (e.g., via the network interface 5-120) one, or both, of the data indicating incidence of at least a first objective occurrence (e.g., game performance of a professional football team) and the data indicating incidence of at least a second objective occurrence (e.g., another game performance of another professional football team) from one or more third party sources 5-50 (e.g., a content provider or web service via a network server).

In various implementations, the objective occurrence data acquisition operation 5-304 of FIG. 5-3 may include an operation 5-522 for acquiring data indicating a second objective occurrence that is at least proximately equivalent to the first objective occurrence as depicted in FIG. 5-5b. For instance, the objective occurrence data acquisition module 5-104 of the computing device 5-10 acquiring (e.g., receiving via a network interface 5-120 or via a user interface 5-122, or by retrieving from memory 5-140) data indicating a second objective occurrence (e.g., a first user 5-20a jogging 30 minutes) that is at least proximately equivalent to the first objective occurrence (e.g., a second user 5-20b jogging 35 minutes).

Operation 5-522, in turn, may include one or more additional operations in various alternative implementations. For example, in some implementations, operation 5-522 may further include an operation 5-524 for acquiring data indicating a second objective occurrence that is at least proximately equivalent in meaning to the first objective occurrence as depicted in FIG. 5-5b. For instance, the objective occurrence data acquisition module 5-104 of the computing device 5-10 acquiring (e.g., receiving via a network interface 5-120 or via a user interface 5-122, or by retrieving from memory 5-140) data indicating a second objective occurrence (e.g., overcast day) that is at least proximately equivalent in meaning to the first objective occurrence (e.g., cloudy day).

In some implementations, operation 5-522 may include an operation 5-526 for acquiring data indicating a second objective occurrence that is same as the first objective occurrence as depicted in FIG. 5-5b. For instance, the objective occurrence data acquisition module 5-104 of the computing device 5-10 acquiring (e.g., receiving via a network interface 5-120 or via a user interface 5-122, or by retrieving from memory 5-140) data indicating a second objective occurrence (e.g., drop in price for a particular stock on a particular day) that is same as the first objective occurrence (e.g., the same drop in price for the same stock on the same day).

In some implementations, the objective occurrence data acquisition operation 5-304 of FIG. 5-3 may include an operation 5-528 for acquiring data indicating at least a second objective occurrence that is a contrasting objective occurrence from the first objective occurrence as depicted in FIG. 5-5b. For instance, the objective occurrence data acquisition module 5-104 of the computing device 5-10 acquiring (e.g., receiving via a network interface 5-120 or via a user interface 5-122, or by retrieving from memory 5-140) data indicating at least a second objective occurrence (e.g., high blood pressure of a first user 5-20a) that is a contrasting objective occurrence from the first objective occurrence (e.g., low blood pressure of a second user 5-20b).

In some implementations, the objective occurrence data acquisition operation 5-304 may include an operation 5-530 for acquiring data indicating a second objective occurrence that references the first objective occurrence as depicted in FIG. 5-5c. For instance, the objective occurrence data acquisition module 5-104 of the computing device 5-10 acquiring (e.g., receiving via a network interface 5-120 or via a user interface 5-122, or by retrieving from memory 5-140) data indicating a second objective occurrence that references the first objective occurrence (e.g., Tuesday's temperature was the same as Monday's temperature or a blood pressure of a second user 5-20b is higher, lower, or the same as the blood pressure of a first user 5-20a).

In various alternative implementations, operation 5-530 may further include one or more additional operations. For example, in some implementations, operation 5-530 may include an operation 5-532 for acquiring data indicating a second objective occurrence that is a comparison to the first objective occurrence as depicted in FIG. 5-5c. For instance, the objective occurrence data acquisition module 5-104 of the computing device 5-10 acquiring (e.g., receiving via a network interface 5-120 or via a user interface 5-122, or by retrieving from memory 5-140) data indicating a second objective occurrence that is a comparison to the first objective occurrence. For example, acquiring data that indicates that it is hotter today (e.g., first objective occurrence) than yesterday (e.g., second objective occurrence).

In some implementations, operation 5-530 may include an operation 5-534 for acquiring data indicating a second objective occurrence that is a modification of the first objective occurrence as depicted in FIG. 5-5c. For instance, the objective occurrence data acquisition module 5-104 of the computing device 5-10 acquiring (e.g., receiving via a network interface 5-120 or via a user interface 5-122, or by retrieving from memory 5-140) data indicating a second objective occurrence that is a modification of the first objective occurrence (e.g., the rain showers yesterday has changed over to a snow storm).

In some implementations, operation 5-530 may include an operation 5-536 for acquiring data indicating a second objective occurrence that is an extension of the first objective occurrence as depicted in FIG. 5-5c. For instance, the objective occurrence data acquisition module 5-104 of the computing device 5-10 acquiring (e.g., receiving via a network interface 5-120 or via a user interface 5-122, or by retrieving from memory 5-140) data indicating a second objective occurrence that is an extension of the first objective occurrence (e.g., yesterday's hot weather continues today).

In some implementations, the objective occurrence data acquisition operation 5-304 may include an operation 5-538 for acquiring a time stamp associated with the at least first objective occurrence as depicted in FIG. 5-5c. For instance, the time stamp acquisition module 5-218 of the computing device 5-10 acquiring (e.g., receiving or generating) a time stamp associated with the at least first objective occurrence.

Operation 5-538, in various implementations, may further include an operation 5-540 for acquiring another time stamp associated with the at least second objective occurrence as depicted in FIG. 5-5c. For instance, the time stamp acquisition module 5-218 of the computing device 5-10 acquiring (e.g., receiving or self-generating) another time stamp associated with the at least second objective occurrence.

In some implementations, the objective occurrence data acquisition operation 5-304 of FIG. 5-3 may include an operation 5-542 for acquiring an indication of a time interval associated with the at least first objective occurrence as depicted in FIG. 5-5c. For instance, the time interval indication acquisition module 5-219 of the computing device 5-10 acquiring (e.g., receiving or self-generating) an indication of a time interval associated with the at least first objective occurrence.

Operation 5-542, in various implementations, may further include an operation 5-544 for acquiring another indication of a time interval associated with the at least second objective occurrence as depicted in FIG. 5-5c. For instance, the time interval indication acquisition module 5-219 of the computing device 5-10 acquiring (e.g., receiving or self-generating) another indication of a time interval associated with the at least second objective occurrence.

In some implementations, the objective occurrence data acquisition operation 5-304 may include an operation 5-546 for acquiring data indicating one or more attributes associated with the first objective occurrence as depicted in FIG. 5-5c. For instance, the objective occurrence data acquisition module 5-104 of the computing device 5-10 acquiring (e.g., via the network interface 5-120, via the user interface 5-122, or by retrieving from a memory 5-140) data indicating one or more attributes (e.g., type of exercising machine or length of time on the exercise machine by a first user 5-20a) associated with the first objective occurrence (e.g., exercising on an exercising machine by the first user 5-20a).

Operation 5-546, in turn, may further include an operation 5-548 for acquiring data indicating one or more attributes associated with the second objective occurrence as depicted in FIG. 5-5c. For instance, the objective occurrence data acquisition module 5-104 of the computing device 5-10 acquiring (e.g., via the network interface 5-120, via the user interface 5-122, or by retrieving from a memory 5-140) data indicating one or more attributes (e.g., type of exercising machine or length of time on the exercise machine by a second user 5-20b) associated with the second objective occurrence (e.g., exercising on an exercising machine by the second user 5-20b).

In some implementations, the objective occurrence data acquisition operation 5-304 of FIG. 5-3 may include an operation 5-550 for acquiring data indicating at least an ingestion by the first user of a medicine as depicted in FIG. 5-5d. For instance, the objective occurrence data acquisition module 5-104 of the computing device 5-10 acquiring (e.g., via the network interface 5-120, via the user interface 5-122, or by retrieving from a memory 5-140) data indicating at least an ingestion by the first user 5-20a of a medicine (e.g., a dosage of a beta blocker).

Operation 5-550, in turn, may include one or more additional operations in various alternative implementations. For example, in some implementations, operation 5-550 may include an operation 5-551 for acquiring data indicating at least an ingestion by the second user of a medicine as depicted in FIG. 5-5d. For instance, the objective occurrence data acquisition module 5-104 of the computing device 5-10 acquiring (e.g., via the network interface 5-120, via the user interface 5-122, or by retrieving from a memory 5-140) data indicating at least an ingestion by the second user 5-20b of a medicine (e.g., ingestion of the same type of beta blocker ingested by the first user 5-20a, ingestion of a different type of beta blocker, or ingestion of a completely different type of medicine).

In some implementations, operation 5-551 may further include an operation 5-552 for acquiring data indicating ingestions of same or similar types of medicine by the first user and the second user as depicted in FIG. 5-5d. For instance, the objective occurrence data acquisition module 5-104 of the computing device 5-10 acquiring (e.g., via the network interface 5-120, via the user interface 5-122, or by retrieving from a memory 5-140) data indicating ingestions of same or similar types of medicine by the first user 5-20a and the second user 5-20b (e.g., ingestions of the same or similar quantities of the same or similar brands of beta blockers).

Operation 5-552, in turn, may further include an operation 5-553 for acquiring data indicating ingestions of same or similar quantities of the same or similar type of medicine by the first user and the second user as depicted in FIG. 5-5d. For instance, the objective occurrence data acquisition module 5-104 of the computing device 5-10 acquiring (e.g., via the network interface 5-120, via the user interface 5-122, or by retrieving from a memory 5-140) data indicating ingestions of same or similar types of medicine (e.g., same or similar quantities of the same brand of beta blockers) by the first user 5-20a and the second user 5-20b.

In some implementations, operation 5-550 may include an operation 5-554 for acquiring data indicating at least an ingestion by the second user of another medicine, the another medicine ingested by the second user being a different type of medicine from the medicine ingested by the first user as depicted in FIG. 5-5d. For instance, the objective occurrence data acquisition module 5-104 of the computing device 5-10 acquiring (e.g., via the network interface 5-120, via the user interface 5-122, or by retrieving from a memory 5-140) data indicating at least an ingestion by the second user 5-20b of another medicine, the another medicine ingested by the second user 5-20b being a different type of medicine from the medicine ingested by the first user 5-20a (e.g., the second user 5-20b ingesting acetaminophen instead of ingesting an aspirin as ingested by the first user 5-20a).

In some implementations, the objective occurrence data acquisition operation 5-304 of FIG. 5-3 may include an operation 5-555 for acquiring data indicating at least an ingestion by the first user of a food item as depicted in FIG. 5-5d. For instance, the objective occurrence data acquisition module 5-104 of the computing device 5-10 acquiring (e.g., via the network interface 5-120, via the user interface 5-122, or by retrieving from a memory 5-140) data indicating at least an ingestion by the first user 5-20a of a food item (e.g., an apple).

Operation 5-555, in turn, may include one or more additional operations in various alternative implementations. For example, in some implementations, operation 5-555 may include an operation 5-556 for acquiring data indicating at least an ingestion by the second user of a food item as depicted in FIG. 5-5d. For instance, the objective occurrence data acquisition module 5-104 of the computing device 5-10 acquiring (e.g., via the network interface 5-120, via the user interface 5-122, or by retrieving from a memory 5-140) data indicating at least an ingestion by the second user 5-20b of a food item (e.g., an apple, an orange, a hamburger, or some other food item).

Operation 5-556, in turn, may further include an operation 5-557 for acquiring data indicating ingestions of same or similar types of food items by the first user and the second user as depicted in FIG. 5-5d. For instance, the objective occurrence data acquisition module 5-104 of the computing device 5-10 acquiring (e.g., via the network interface 5-120, via the user interface 5-122, or by retrieving from a memory 5-140) data indicating ingestions of same or similar types of food items (e.g., same or different types of apple) by the first user 5-20a and the second user 5-20b.

In some implementations, operation 5-557 may include an operation 5-558 for acquiring data indicating ingestions of same or similar quantities of the same or similar types of food items by the first user and the second user as depicted in FIG. 5-5d. For instance, the objective occurrence data acquisition module 5-104 of the computing device 5-10 acquiring (e.g., via the network interface 5-120, via the user interface 5-122, or by retrieving from a memory 5-140) data indicating ingestions of same or similar quantities of the same or similar types of food items (e.g., consuming 10 ounces of the same or different types of apple) by the first user 5-20a and the second user 5-20b.

In some implementations, operation 5-555 may include an operation 5-559 for acquiring data indicating at least an ingestion by the second user of another food item, the another food item ingested by the second user being a different food item from the food item ingested by the first user as depicted in FIG. 5-5d. For instance, the objective occurrence data acquisition module 5-104 of the computing device 5-10 acquiring (e.g., via the network interface 5-120, via the user interface 5-122, or by retrieving from a memory 5-140) data indicating at least an ingestion by the second user 5-20b of another food item (e.g., hamburger), the another food item ingested by the second user 5-20b being a different food item from the food item (e.g., apple) ingested by the first user 5-20a.

In some implementations, the objective occurrence data acquisition operation 5-304 of FIG. 5-3 may include an operation 5-560 for acquiring data indicating at least an ingestion by the first user of a nutraceutical as depicted in FIG. 5-5e. For instance, the objective occurrence data acquisition module 5-104 of the computing device 5-10 acquiring (e.g., via the network interface 5-120, via the user interface 5-122, or by retrieving from a memory 5-140) data indicating at least an ingestion by the first user 5-20a of a nutraceutical (e.g., broccoli).

Operation 5-560, in turn, may include one or more additional operations in various alternative implementations. For example, in some implementations, operation 5-560 may include an operation 5-561 for acquiring data indicating at least an ingestion by the second user of a nutraceutical as depicted in FIG. 5-5e. For instance, the objective occurrence data acquisition module 5-104 of the computing device 5-10 acquiring (e.g., via the network interface 5-120, via the user interface 5-122, or by retrieving from a memory 5-140) data indicating at least an ingestion by the second user 5-20b of a nutraceutical (e.g., broccoli, red grapes, soy beans, or some other type of nutraceutical).

Operation 5-561, in turn, may further include an operation 5-562 for acquiring data indicating ingestions of same or similar type of nutraceutical by the first user and the second user as depicted in FIG. 5-5e. For instance, the objective occurrence data acquisition module 5-104 of the computing device 5-10 acquiring (e.g., via the network interface 5-120, via the user interface 5-122, or by retrieving from a memory 5-140) data indicating ingestions of same or similar type (e.g., same or different types of red grapes) of nutraceutical by the first user 5-20a and the second user 5-20b.

In some implementations, operation 5-562 may further include an operation 5-563 for acquiring data indicating ingestions of same or similar quantity of the same or similar type of nutraceutical by the first user and the second user as depicted in FIG. 5-5e. For instance, the objective occurrence data acquisition module 5-104 of the computing device 5-10 acquiring (e.g., via the network interface 5-120, via the user interface 5-122, or by retrieving from a memory 5-140) data indicating ingestions of same or similar quantity of the same or similar type of nutraceutical (e.g., 10 ounces of the same or different types of red grapes) by the first user 5-20a and the second user 5-20b.

In some implementations, operation 5-560 may include an operation 5-564 for acquiring data indicating at least an ingestion by the second user of another nutraceutical, the another nutraceutical ingested by the second user being a different type of nutraceutical from the nutraceutical ingested by the first user as depicted in FIG. 5-5e. For instance, the objective occurrence data acquisition module 5-104 of the computing device 5-10 acquiring (e.g., via the network interface 5-120, via the user interface 5-122, or by retrieving from a memory 5-140) data indicating at least an ingestion by the second user 5-20b of another nutraceutical (e.g., red grapes), the another nutraceutical ingested by the second user 5-20b being a different type of nutraceutical from the nutraceutical (e.g., broccoli) ingested by the first user 5-20a.

In some implementations, the objective occurrence data acquisition operation 5-304 of FIG. 5-3 may include an operation 5-565 for acquiring data indicating at least an exercise routine executed by the first user as depicted in FIG. 5-5e. For instance, the objective occurrence data acquisition module 5-104 of the computing device 5-10 acquiring (e.g., via the network interface 5-120, via the user interface 5-122, or by retrieving from a memory 5-140) data indicating at least an exercise routine (e.g., jogging) executed by the first user 5-20a.

Operation 5-565, in turn, may further include one or more additional operations in various alternative implementations. For example, in some implementations, operation 5-565 may include an operation 5-566 for acquiring data indicating at least an exercise routine executed by the second user as depicted in FIG. 5-5e. For instance, the objective occurrence data acquisition module 5-104 of the computing device 5-10 acquiring (e.g., via the network interface 5-120, via the user interface 5-122, or by retrieving from a memory 5-140) data indicating at least an exercise routine (e.g., jogging or some other exercise routine such as weightlifting, aerobics, treadmill, and so forth) executed by the second user 5-20b.

Operation 5-566, in turn, may further include an operation 5-567 for acquiring data indicating same or similar types of exercise routines executed by the first user and the second user as depicted in FIG. 5-5e. For instance, the objective occurrence data acquisition module 5-104 of the computing device 5-10 acquiring (e.g., via the network interface 5-120, via the user interface 5-122, or by retrieving from a memory 5-140) data indicating same or similar types of exercise routines (e.g., swimming) executed by the first user 5-20a and the second user 5-20b.

In some implementations, operation 5-567 may further include an operation 5-568 for acquiring data indicating same or similar quantities of the same or similar types of exercise routines executed by the first user and the second user as depicted in FIG. 5-5e. For instance, the objective occurrence data acquisition module 5-104 of the computing device 5-10 acquiring (e.g., via the network interface 5-120, via the user interface 5-122, or by retrieving from a memory 5-140) data indicating same or similar quantities of the same or similar types of exercise routines executed (e.g., jogging for 30 minutes) by the first user 5-20a and the second user 5-20b.

In some implementations, operation 5-565 may include an operation 5-569 for acquiring data indicating at least another exercise routine executed by the second user, the another exercise routine executed by the second user being a different type of exercise routine from the exercise routine executed by the first user as depicted in FIG. 5-5e. For instance, the objective occurrence data acquisition module 5-104 of the computing device 5-10 acquiring (e.g., via the network interface 5-120, via the user interface 5-122, or by retrieving from a memory 5-140) data indicating at least another exercise routine (e.g., working out on a treadmill) executed by the second user 5-20b, the another exercise routine executed by the second user 5-20b being a different type of exercise routine from the exercise routine (e.g., working out on an elliptical machine) executed by the first user 5-20a.

In some implementations, the objective occurrence data acquisition operation 5-304 of FIG. 5-3 may include an operation 5-570 for acquiring data indicating at least a social activity executed by the first user as depicted in FIG. 5-5f. For instance, the objective occurrence data acquisition module 5-104 of the computing device 5-10 acquiring (e.g., via the network interface 5-120, via the user interface 5-122, or by retrieving from a memory 5-140) data indicating at least a social activity (e.g., hiking with friends) executed by the first user 5-20a.

Operation 5-570, in turn, may further include one or more additional operations in various alternative implementations. For example, in some implementations, operation 5-570 may include an operation 5-571 for acquiring data indicating at least a social activity executed by the second user as depicted in FIG. 5-5f. For instance, the objective occurrence data acquisition module 5-104 of the computing device 5-10 acquiring (e.g., via the network interface 5-120, via the user interface 5-122, or by retrieving from a memory 5-140) data indicating at least a social activity (e.g., hiking with friends or some other social activity such as skiing with friends, dining with friends, and so forth) executed by the second user 5-20b.

In some implementations, operation 5-571 may include an operation 5-572 for acquiring data indicating same or similar types of social activities executed by the first user and the second user as depicted in FIG. 5-5f. For instance, the objective occurrence data acquisition module 5-104 of the computing device 5-10 acquiring (e.g., via the network interface 5-120, via the user interface 5-122, or by retrieving from a memory 5-140) data indicating same or similar types of social activities (e.g., visiting in-laws) executed by the first user 5-20a and the second user 5-20b.

In some implementations, operation 5-571 may include an operation 5-573 for acquiring data indicating different types of social activities executed by the first user and the second user as depicted in FIG. 5-5f. For instance, the objective occurrence data acquisition module 5-104 of the computing device 5-10 acquiring (e.g., via the network interface 5-120, via the user interface 5-122, or by retrieving from a memory 5-140) data indicating different types of social activities executed by the first user 5-20a (e.g., attending a family dinner) and the second user 5-20b (e.g., attending a dinner with friends).

In some implementations, the objective occurrence data acquisition operation 5-304 of FIG. 5-3 may include an operation 5-574 for acquiring data indicating at least an activity executed by a third party as depicted in FIG. 5-5f. For instance, the objective occurrence data acquisition module 5-104 of the computing device 5-10 acquiring (e.g., via the network interface 5-120, via the user interface 5-122, or by retrieving from a memory 5-140) data indicating at least an activity (e.g., a boss on a vacation) executed by a third party.

Operation 5-574, in turn, may further include one or more additional operations in various alternative implementations. For example, in some implementations, operation 5-574 may include an operation 5-575 for acquiring data indicating at least another activity executed by the third party or by another third party as depicted in FIG. 5-5f. For instance, the objective occurrence data acquisition module 5-104 of the computing device 5-10 acquiring (e.g., via the network interface 5-120, via the user interface 5-122, or by retrieving from a memory 5-140) data indicating at least another activity (e.g., a boss on a vacation, a boss away from office on business trip, or a boss in the office) executed by the third party or by another third party.

In some implementations, operation 5-575 may include an operation 5-576 for acquiring data indicating same or similar types of activities executed by the third party or by the another third party as depicted in FIG. 5-5f. For instance, the objective occurrence data acquisition module 5-104 of the computing device 5-10 acquiring (e.g., via the network interface 5-120, via the user interface 5-122, or by retrieving from a memory 5-140) data indicating same or similar types of activities (e.g., a boss or bosses away on a business trip) executed by the third party or by the another third party.

In some implementations, operation 5-575 may include an operation 5-577 for acquiring data indicating different types of activities executed by the third party or by the another third party as depicted in FIG. 5-5f. For instance, the objective occurrence data acquisition module 5-104 of the computing device 5-10 acquiring (e.g., via the network interface 5-120, via the user interface 5-122, or by retrieving from a memory 5-140) data indicating different types of activities (e.g., a boss leaving for vacation as opposed to returning from a vacation) executed by the third party or by the another third party.

In some implementations, the objective occurrence data acquisition operation 5-304 of FIG. 5-3 may include an operation 5-578 for acquiring data indicating at least a physical characteristic associated with the first user as depicted in FIG. 5-5f. For instance, the objective occurrence data acquisition module 5-104 of the computing device 5-10 acquiring (e.g., via the network interface 5-120, via the user interface 5-122, or by retrieving from a memory 5-140) data indicating at least a physical characteristic (e.g., a blood sugar level) associated with the first user 5-20a. Note that a physical characteristic such as a blood sugar level could be determined using a device such as a blood sugar meter and then reported by the first user 5-20a or by a third party 5-50. Alternatively, such results may be reported or provided directly by the meter.

Operation 5-578, in turn, may further include one or more additional operations in various alternative implementations. For example, in some implementations, operation 5-578 may include an operation 5-579 for acquiring data indicating at least a physical characteristic associated with the second user as depicted in FIG. 5-5f. For instance, the objective occurrence data acquisition module 5-104 of the computing device 5-10 acquiring (e.g., via the network interface 5-120, via the user interface 5-122, or by retrieving from a memory 5-140) data indicating at least a physical characteristic (e.g., blood sugar level or a blood pressure level) associated with the second user 5-20b.

In some implementations, operation 5-579 may include an operation 5-580 for acquiring data indicating same or similar physical characteristics associated with the first user and the second user as depicted in FIG. 5-5f. For instance, the objective occurrence data acquisition module 5-104 of the computing device 5-10 acquiring (e.g., via the network interface 5-120, via the user interface 5-122, or by retrieving from a memory 5-140) data indicating same or similar physical characteristics (e.g., blood sugar levels) associated with the first user 5-20a and the second user 5-20b.

In some implementations, operation 5-579 may include an operation 5-581 for acquiring data indicating different physical characteristics associated with the first user and the second user as depicted in FIG. 5-5f. For instance, the objective occurrence data acquisition module 5-104 of the computing device 5-10 acquiring (e.g., via the network interface 5-120, via the user interface 5-122, or by retrieving from a memory 5-140) data indicating different physical characteristics (e.g., blood sugar level as opposed to blood pressure level) associated with the first user 5-20a and the second user 5-20b.

In some implementations, the objective occurrence data acquisition operation 5-304 of FIG. 5-3 may include an operation 5-582 for acquiring data indicating occurrence of at least an external event as depicted in FIG. 5-5g. For instance, the objective occurrence data acquisition module 5-104 of the computing device 5-10 acquiring (e.g., via the network interface 5-120, via the user interface 5-122, or by retrieving from a memory 5-140) data indicating occurrence of at least an external event (e.g., rain storm).

Operation 5-582, in turn, may further include one or more additional operations in various alternative implementations. For example, in some implementations, operation 5-582 may include an operation 5-583 for acquiring data indicating occurrence of at least another external event as depicted in FIG. 5-5g. For instance, the objective occurrence data acquisition module 5-104 of the computing device 5-10 acquiring (e.g., via the network interface 5-120, via the user interface 5-122, or by retrieving from a memory 5-140) data indicating occurrence of at least another external event (e.g., another rain storm or sunny weather).

In some implementations, operation 5-583 may include an operation 5-584 for acquiring data indicating occurrences of same or similar external events as depicted in FIG. 5-5g. For instance, the objective occurrence data acquisition module 5-104 of the computing device 5-10 acquiring (e.g., via the network interface 5-120, via the user interface 5-122, or by retrieving from a memory 5-140) data indicating occurrences of same or similar external events (e.g., rain storms).

In some implementations, operation 5-583 may include an operation 5-585 for acquiring data indicating occurrences of different external events as depicted in FIG. 5-5g. For instance, the objective occurrence data acquisition module 5-104 of the computing device 5-10 acquiring (e.g., via the network interface 5-120, via the user interface 5-122, or by retrieving from a memory 5-140) data indicating occurrences of different external events (e.g., rain storm and sunny weather).

In some implementations, the objective occurrence data acquisition operation 5-304 of FIG. 5-3 may include an operation 5-586 for acquiring data indicating at least a location associated with the first user as depicted in FIG. 5-5g. For instance, the objective occurrence data acquisition module 5-104 of the computing device 5-10 acquiring (e.g., via the network interface 5-120, via the user interface 5-122, or by retrieving from a memory 5-140) data indicating at least a location (e.g., work place) associated with the first user 5-20a.

Operation 5-586, in turn, may further include one or more additional operations in various alternative implementations. For example, in some implementations, operation 5-586 may include an operation 5-587 for acquiring data indicating at least a location associated with the second user as depicted in FIG. 5-5g. For instance, the objective occurrence data acquisition module 5-104 of the computing device 5-10 acquiring (e.g., via the network interface 5-120, via the user interface 5-122, or by retrieving from a memory 5-140) data indicating at least a location (e.g., work place or home) associated with the second user 5-20b.

In some implementations, operation 5-587 may include an operation 5-588 for acquiring data indicating the location associated with the first user that is same as the location associated with the second user as depicted in FIG. 5-5g. For instance, the objective occurrence data acquisition module 5-104 of the computing device 5-10 acquiring (e.g., via the network interface 5-120, via the user interface 5-122, or by retrieving from a memory 5-140) data indicating the location (e.g., Syracuse) associated with the first user 5-20a that is same as the location (e.g., Syracuse) associated with the second user 5-20b.

In some implementations, operation 5-587 may include an operation 5-589 for acquiring data indicating the location associated with the first user that is different from the location associated with the second user as depicted in FIG. 5-5g. For instance, the objective occurrence data acquisition module 5-104 of the computing device 5-10 acquiring (e.g., via the network interface 5-120, via the user interface 5-122, or by retrieving from a memory 5-140) data indicating the location (e.g., Syracuse) associated with the first user 5-20a that is different from the location (e.g., Waikiki) associated with the second user 5-20b.

In some implementations, the objective occurrence data acquisition operation 5-304 of FIG. 5-3 may include an operation 5-590 for acquiring data indicating incidence of at least a third objective occurrence as depicted in FIG. 5-5g. For instance, the objective occurrence data acquisition module 5-104 of the computing device 5-10 acquiring (e.g., via the network interface 5-120, via the user interface 5-122, or by retrieving from a memory 5-140) data indicating incidence of at least a third objective occurrence (e.g., a third objective occurrence that may be associated with a third user 5-20c including, for example, a physical characteristic associated with the third user 5-20c, an activity associated with the third user 5-20c, a location associated with the third user 5-20c, and so forth).

In some implementations, operation 5-590 may further include an operation 5-591 for acquiring data indicating incidence of at least a fourth objective occurrence as depicted in FIG. 5-5g. For instance, the objective occurrence data acquisition module 5-104 of the computing device 5-10 acquiring (e.g., via the network interface 5-120, via the user interface 5-122, or by retrieving from a memory 5-140) data indicating incidence of at least a fourth objective occurrence (e.g., a fourth objective occurrence that may be associated with a fourth user 5-20d including, for example, a physical characteristic associated with the fourth user 5-20d, an activity associated with the fourth user 5-20d, a location associated with the fourth user 5-20d, and so forth).

In various implementations, the correlation operation 5-306 of FIG. 5-3 may include one or more additional operations as illustrated in FIGS. 5-6a, 5-6b, 5-6c, 5-6d, and 5-6e. For example, in some implementations, the correlation operation 5-306 may include an operation 5-602 for correlating the subjective user state data with the objective occurrence data based, at least in part, on determining at least a first sequential pattern associated with the incidence of the at least first subjective user state and the incidence of the at least first objective occurrence as depicted in FIG. 5-6a. For instance, the correlation module 5-106 of the computing device 5-10 correlating the subjective user state data 5-60 with the objective occurrence data 5-70* based, at least in part, on the sequential pattern determination module 5-220 determining at least a first sequential pattern associated with the incidence of the at least first subjective user state (e.g., a first user 5-20a having an upset stomach) and the incidence of the at least first objective occurrence (e.g., the first user 5-20a eating a hot fudge sundae).

In various alternative implementations, operation 5-602 may include one or more additional operations. For example, in some implementations, operation 5-602 may include an operation 5-604 for determining the at least first sequential pattern based, at least in part, on a determination of whether the incidence of the at least first subjective user state occurred within a predefined time increment from the incidence of the at least first objective occurrence as depicted in FIG. 5-6a. For instance, the sequential pattern determination module 5-220 of the computing device 5-10 determining the at least first sequential pattern based, at least in part, on the “within predefined time increment determination” module 5-221 determining whether the incidence of the at least first subjective user state (e.g., a first user 5-20a having an upset stomach) occurred within a predefined time increment (e.g., four hours) from the incidence of the at least first objective occurrence (e.g., the first user 5-20a eating a hot fudge sundae).

In some implementations, operation 5-602 may include an operation 5-606 for determining the first sequential pattern based, at least in part, on a determination of whether the incidence of the at least first subjective user state occurred before, after, or at least partially concurrently with the incidence of the at least first objective occurrence as depicted in FIG. 5-6a. For instance, the sequential pattern determination module 5-220 of the computing device 5-10 determining the at least first sequential pattern based, at least in part, on the temporal relationship determination module 5-222 determining whether the incidence of the at least first subjective user state (e.g., a first user 5-20a having an upset stomach) occurred before, after, or at least partially concurrently with the incidence of the at least first objective occurrence (e.g., the first user 5-20a eating a hot fudge sundae).

In some implementations, operation 5-602 may include an operation 5-608 for correlating the subjective user state data with the objective occurrence data based, at least in part, on determining a second sequential pattern associated with the incidence of the at least second subjective user state and the incidence of the at least second objective occurrence as depicted in FIG. 5-6a. For instance, the correlation module 5-106 of the computing device 5-10 correlating the subjective user state data 5-60 with the objective occurrence data 5-70* based, at least in part, on the sequential pattern determination module 5-220 determining a second sequential pattern associated with the incidence of the at least second subjective user state (e.g., a second user 5-20b having an upset stomach) and the incidence of the at least second objective occurrence (e.g., the second user 5-20b also eating a hot fudge sundae).

In various alternative implementations, operation 5-608 may include one or more additional operations. For example, in some implementations, operation 5-608 may include an operation 5-610 for correlating the subjective user state data with the objective occurrence data based, at least in part, on a comparison of the first sequential pattern to the second sequential pattern as depicted in FIG. 5-6a. For instance, the correlation module 5-106 of the computing device 5-10 correlating the subjective user state data 5-60 with the objective occurrence data 5-70* based, at least in part, on the sequential pattern comparison module 5-224 comparing the first sequential pattern to the second sequential pattern (e.g., comparing to determine whether they are the same, similar, or different patterns).

In various implementations, operation 5-610 may further include an operation 5-612 for correlating the subjective user state data with the objective occurrence data based, at least in part, on determining whether the first sequential pattern at least substantially matches with the second sequential pattern as depicted in FIG. 5-6a. For instance, the correlation module 5-106 of the computing device 5-10 correlating the subjective user state data 5-60 with the objective occurrence data 5-70* based, on the sequential pattern comparison module 5-224 determining whether the first sequential pattern at least substantially matches with the second sequential pattern.

In some implementations, operation 5-612 may include an operation 5-614 for determining whether the first subjective user state is equivalent to the second subjective user state as depicted in FIG. 5-6a. For instance, the subjective user state equivalence determination module 5-225 (see FIG. 5-2c) of the computing device 5-10 determining whether the first subjective user state (e.g., upset stomach) associated with the first user 5-20a is equivalent to the second subjective user state (e.g., stomach ache) associated with the second user 5-20b.

In some implementations, operation 5-612 may include an operation 5-616 for determining whether the first subjective user state is at least proximately equivalent to the second subjective user state as depicted in FIG. 5-6a. For instance, the subjective user state equivalence determination module 5-225 (see FIG. 5-2c) of the computing device 5-10 determining whether the first subjective user state (e.g., upset stomach) is at least proximately equivalent to the second subjective user state (e.g., stomach ache).

In various implementations, operation 5-612 of FIG. 5-6a may include an operation 5-618 for determining whether the first subjective user state is a contrasting subjective user state from the second subjective user state as depicted in FIG. 5-6b. For instance, the subjective user state contrast determination module 5-227 of the computing device 5-10 determining whether the first subjective user state (e.g., extreme pain) is a contrasting subjective user state from the second subjective user state (e.g., moderate or no pain).

In some implementations, operation 5-612 may include an operation 5-620 for determining whether the first objective occurrence is equivalent to the second objective occurrence as depicted in FIG. 5-6b. For instance, the objective occurrence equivalence determination module 5-226 of the computing device 5-10 determining whether the first objective occurrence (e.g., consuming green tea by a first user 5-20a) is equivalent to the second objective occurrence (e.g., consuming green tea by a second user 5-20b).

In some implementations, operation 5-612 may include an operation 5-622 for determining whether the first objective occurrence is at least proximately equivalent to the second objective occurrence as depicted in FIG. 5-6b. For example, the objective occurrence equivalence determination module 5-226 of the computing device determining whether the first objective occurrence (e.g., overcast day) is at least proximately equivalent to the second objective occurrence (e.g., cloudy day).

In some implementations, operation 5-612 may include an operation 5-624 for determining whether the first objective occurrence is a contrasting objective occurrence from the second objective occurrence as depicted in FIG. 5-6b. For instance, the objective occurrence contrast determination module 5-228 of the computing device 5-10 determining whether the first objective occurrence (e.g., a first user 5-20a jogging for 30 minutes) is a contrasting objective occurrence from the second objective occurrence (e.g., a second user 5-20b jogging for 25 minutes).

In various implementations, operation 5-610 of FIGS. 5-6a and 5-6b may include an operation 5-626 for correlating the subjective user state data with the objective occurrence data based, at least in part, on a comparison between the first sequential pattern, the second sequential pattern, and a third sequential pattern associated with incidence of at least a third subjective user state associated with a third user and incidence of at least a third objective occurrence as depicted in FIG. 5-6c. For example, the correlation module 5-106 of the computing device 5-10 correlating the subjective user state data 5-60 with the objective occurrence data 5-70* based, at least in part, on the sequential pattern comparison module 5-224 making a comparison between the first sequential pattern, the second sequential pattern, and a third sequential pattern associated with incidence of at least a third subjective user state associated with a third user 5-20c and incidence of at least a third objective occurrence.

In some implementations, operation 5-626 may include an operation 5-628 for correlating the subjective user state data with the objective occurrence data based, at least in part, on a comparison between the first sequential pattern, the second sequential pattern, the third sequential pattern, and a fourth sequential pattern associated with incidence of at least a fourth subjective user state associated with a fourth user and incidence of at least a fourth objective occurrence as depicted in FIG. 5-6c. For example, the correlation module 5-106 of the computing device 5-10 correlating the subjective user state data 5-60 with the objective occurrence data 5-70* based, at least in part, on the sequential pattern comparison module 5-224 making a comparison between the first sequential pattern, the second sequential pattern, the third sequential pattern, and a fourth sequential pattern associated with incidence of at least a fourth subjective user state associated with a fourth user 5-20d and incidence of at least a fourth objective occurrence.

In various implementations, operation 5-608 of FIGS. 5-6a, 5-6b, and 5-6c may include an operation 5-630 for determining the first sequential pattern based, at least in part, on determining whether the incidence of the at least first subjective user state occurred before, after, or at least partially concurrently with the incidence of the at least first objective occurrence as depicted in FIG. 5-6d. For instance, the sequential pattern determination module 5-220 of the computing device 5-10 determining the first sequential pattern based, at least in part, on the temporal relationship determination module 5-222 determining whether the incidence of the at least first subjective user state (e.g., depression) occurred before, after, or at least partially concurrently with the incidence of the at least first objective occurrence (e.g., overcast weather).

In some implementations, operation 5-630 may further include an operation 5-632 for determining the second sequential pattern based, at least in part, on determining whether the incidence of the at least second subjective user state occurred before, after, or at least partially concurrently with the incidence of the at least second objective occurrence as depicted in FIG. 5-6d. For instance, the sequential pattern determination module 5-220 of the computing device 5-10 determining the second sequential pattern based, at least in part, on the temporal relationship determination module 5-222 determining whether the incidence of the at least second subjective user state (e.g., sadness) occurred before, after, or at least partially concurrently with the incidence of the at least second objective occurrence (e.g., overcast weather).

In various implementations, the correlation operation 5-306 of FIG. 5-3 may include an operation 5-634 for correlating the subjective user state data with the objective occurrence data based, at least in part, on referencing historical data as depicted in FIG. 5-6d. For instance, the historical data referencing module 5-230 (see FIG. 5-2c) of the computing device 5-10 correlating the subjective user state data 5-60 with the objective occurrence data 5-70* based, at least in part, on referencing historical data 5-72 (e.g., population trends such as the superior efficacy of ibuprofen as opposed to acetaminophen in reducing toothaches in the general population, user medical data such as genetic, metabolome, or proteome information, historical sequential patterns particular to the user 5-20* or to the overall population such as people having a hangover after drinking excessively, and so forth).

In various implementations, operation 5-634 may include one or more additional operations. For example, in some implementations, operation 5-634 may include an operation 5-636 for correlating the subjective user state data with the objective occurrence data based, at least in part, on historical data indicative of a link between a subjective user state type and an objective occurrence type as depicted in FIG. 5-6d. For instance, the historical data referencing module 5-230 of the computing device 5-10 correlating the subjective user state data 5-60 with the objective occurrence data 5-70* based, at least in part, on historical data 5-72 indicative of a link between a subjective user state type and an objective occurrence type (e.g., historical data 5-72 suggests or indicate a link between a person's mental well-being and exercise).

Operation 5-636, in turn, may further include an operation 5-638 for correlating the subjective user state data with the objective occurrence data based, at least in part, on a historical sequential pattern as depicted in FIG. 5-6d. For instance, the historical data referencing module 5-230 of the computing device 5-10 correlating the subjective user state data 5-60 with the objective occurrence data 5-70* based, at least in part, on a historical sequential pattern (e.g., research indicates that people tend to feel better after exercising).

In some implementations, operation 5-634 may further include an operation 5-640 for correlating the subjective user state data with the objective occurrence data based, at least in part, on historical medical data as depicted in FIG. 5-6d. For instance, the historical data referencing module 5-230 of the computing device 5-10 correlating the subjective user state data 5-60 with the objective occurrence data 5-70* based, at least in part, on a historical medical data (e.g., genetic, metabolome, or proteome information or medical records of one or more users 5-20* or of others).

In some implementations, the correlation operation 5-306 of FIG. 5-3 may include an operation 5-642 for determining strength of correlation between the subjective user state data and the objective occurrence data as depicted in FIG. 5-6e. For instance, the strength of correlation determination module 5-231 (see FIG. 5-2c) of the computing device 5-10 determining strength of correlation between the subjective user state data 5-60 and the objective occurrence data 5-70*.

In some implementations, the correlation operation 5-306 may include an operation 5-644 for correlating the subjective user state data with the objective occurrence data at a server as depicted in FIG. 5-6e. For instance, the correlation module 5-106 of the computing device 5-10 correlating the subjective user state data 5-60 with the objective occurrence data 5-70* when the computing device 5-10 is a network server.

In some implementations, the correlation operation 5-306 may include an operation 5-646 for correlating the subjective user state data with the objective occurrence data at a handheld device as depicted in FIG. 5-6e. For instance, the correlation module 5-106 of the computing device 5-10 correlating the subjective user state data 5-60 with the objective occurrence data 5-70* when the computing device 5-10 is a handheld device.

In some implementations, the correlation operation 5-306 may include an operation 5-648 for correlating the subjective user state data with the objective occurrence data at a peer-to-peer network component device as depicted in FIG. 5-6e. For instance, the correlation module 5-106 of the computing device 5-10 correlating the subjective user state data 5-60 with the objective occurrence data 5-70* when the computing device 5-10 is a peer-to-peer network component device.

Referring to FIG. 5-7 illustrating another operational flow 5-700 in accordance with various embodiments. Operational flow 5-700 includes operations that mirror the operations included in the operational flow 5-300 of FIG. 5-3. These operations include a subjective user state data acquisition operation 5-702, an objective occurrence data acquisition operation 5-704, and a correlation operation 5-706 that correspond to and mirror the subjective user state data acquisition operation 5-302, the objective occurrence data acquisition operation 5-304, and the correlation operation 5-306, respectively, of FIG. 5-3.

In addition, operational flow 5-700 includes a presentation operation 5-708 for presenting one or more results of the correlating as depicted in FIG. 5-7. For instance, the presentation module 5-108 of the computing device 5-10 presenting (e.g., by transmitting via network interface 5-120 or by indicating via user interface 5-122) one or more results of a correlating performed by the correlation module 5-106.

In various implementations, the presentation operation 5-708 may include one or more additional operations as depicted in FIG. 5-8. For example, in some implementations, the presentation operation 5-708 may include an operation 5-802 for indicating the one or more results via a user interface. For instance, the user interface indication module 5-233 (see FIG. 5-2d) of the computing device 5-10 indicating the one or more results of the correlation operation performed by the correlation module 5-106 via a user interface 5-122 (e.g., a touchscreen, a display monitor, an audio system including a speaker, and/or other devices).

In various implementations, the presentation operation 5-708 may include an operation 5-804 for transmitting the one or more results via a network interface. For instance, the network interface transmission module 5-232 of the computing device 5-10 transmitting the one or more results of the correlation operation performed by the correlation module 5-106 via a network interface 5-120.

In some implementations, operation 5-804 may further include an operation 5-806 for transmitting the one or more results to one, or both, the first user and the second user. For example, the network interface transmission module 5-232 of the computing device 5-10 transmitting the one or more results of the correlation operation performed by the correlation module 5-106 to one, or both, the first user 5-20a and the second user 5-20b.

In some implementations, operation 5-804 may further include an operation 5-808 for transmitting the one or more results to one or more third parties. For example, the network interface transmission module 5-232 of the computing device 5-10 transmitting the one or more results of the correlation operation performed by the correlation module 5-106 to one or more third parties (e.g., third party sources 5-50).

In some implementations, the presentation operation 5-708 may include an operation 5-810 for presenting a prediction of a future subjective user state resulting from a future objective occurrence as depicted in FIG. 5-8. For instance, the prediction presentation module 5-236 (see FIG. 5-2d) of the computing device 5-10 presenting (e.g., transmitting via a network interface 5-120 or by indicating via a user interface 5-122) a prediction of a future subjective user state resulting from a future objective occurrence. An example prediction might state that “if the user drinks five shots of whiskey tonight, the user will have a hangover tomorrow.”

In some implementations, the presentation operation 5-708 may include an operation 5-812 for presenting a prediction of a future subjective user state resulting from a past objective occurrence as depicted in FIG. 5-8. For instance, the prediction presentation module 5-236 of the computing device 5-10 presenting (e.g., transmitting via a network interface 5-120 or by indicating via a user interface 5-122) a prediction of a future subjective user state resulting from a past objective occurrence. An example prediction might state that “the user will have a hangover tomorrow since the user drank five shots of whiskey tonight.”

In some implementations, the presentation operation 5-708 may include an operation 5-814 for presenting a past subjective user state in connection with a past objective occurrence as depicted in FIG. 5-8. For instance, the past presentation module 5-238 of the computing device 5-10 presenting (e.g., transmitting via a network interface 5-120 or by indicating via a user interface 5-122) a past subjective user state in connection with a past objective occurrence. An example of such a presentation might state that “the user got depressed the last time it rained.”

In various implementations, the presentation operation 5-708 may include an operation 5-816 for presenting a recommendation for a future action as depicted in FIG. 5-8. For instance, the recommendation module 5-240 of the computing device 5-10 presenting (e.g., transmitting via a network interface 5-120 or by indicating via a user interface 5-122) a recommendation for a future action. An example recommendation might state that “the user should not drink five shots of whiskey.”

In some implementations, operation 5-816 may include an operation 5-818 for presenting a justification for the recommendation as depicted in FIG. 5-8. For instance, the justification module 5-242 of the computing device 5-10 presenting (e.g., transmitting via a network interface 5-120 or by indicating via a user interface 5-122) a justification for the recommendation. An example justification might state that “the user should not drink five shots of whiskey because the last time the user drank five shots of whiskey, the user got a hangover.”

### VII: Hypothesis Based Solicitation of Data Indicating at Least One Subjective User State

In the following detailed description, reference is made to the accompanying drawings, which form a part hereof. In the drawings, similar symbols typically identify similar components, unless context dictates otherwise. The illustrative embodiments described in the detailed description, drawings, and claims are not meant to be limiting. Other embodiments may be utilized, and other changes may be made, without departing from the spirit or scope of the subject matter presented here.

A recent trend that is becoming increasingly popular in the computing/communication field is to electronically record one's feelings, thoughts, and other aspects of the person's everyday life onto an open diary. One place where such open diaries are maintained are at social networking sites commonly known as “blogs” where one or more users may report or post their thoughts and opinions on various topics, latest news, current events, and various other aspects of the users' everyday life. The process of reporting or posting blog entries is commonly referred to as blogging. Other social networking sites may allow users to update their personal information via, for example, social network status reports in which a user may report or post for others to view the latest status or other aspects of the user.

A more recent development in social networking is the introduction and explosive growth of microblogs in which individuals or users (referred to as “microbloggers”) maintain open diaries at microblog websites (e.g., otherwise known as “twitters”) by continuously or semi-continuously posting microblog entries. A microblog entry (e.g., “tweet”) is typically a short text message that is usually not more than 140 characters long. The microblog entries posted by a microblogger may report on any aspect of the microblogger's daily life.

The various things that are typically posted through microblog entries may be categorized into one of at least two possible categories. The first category of things that may be reported through microblog entries are “objective occurrences” that may or may not be associated with the microblogger. Objective occurrences that are associated with a microblogger may be any characteristic, event, happening, or any other aspects associated with or are of interest to the microblogger that can be objectively reported by the microblogger, a third party, or by a device. These things would include, for example, food, medicine, or nutraceutical intake of the microblogger, certain physical characteristics of the microblogger such as blood sugar level or blood pressure that can be objectively measured, daily activities of the microblogger observable by others or by a device, performance of the stock market (which the microblogger may have an interest in), and so forth. In some cases, objective occurrences may not be at least directly associated with a microblogger. Examples of such objective occurrences include, for example, external events that may not be directly related to the microblogger such as the local weather, activities of others (e.g., spouse or boss) that may directly or indirectly affect the microblogger, and so forth.

A second category of things that may be reported or posted through microblog entries include “subjective user states” of the microblogger. Subjective user states of a microblogger include any subjective state or status associated with the microblogger that can only be typically reported by the microblogger (e.g., generally cannot be reported by a third party or by a device). Such states including, for example, the subjective mental state of the microblogger (e.g., “I am feeling happy”), the subjective physical state of the microblogger (e.g., “my ankle is sore” or “my ankle does not hurt anymore” or “my vision is blurry”), and the subjective overall state of the microblogger (e.g., “I'm good” or “I'm well”). Note that the term “subjective overall state” as will be used herein refers to those subjective states that may not fit neatly into the other two categories of subjective user states described above (e.g., subjective mental states and subjective physical states). Although microblogs are being used to provide a wealth of personal information, they have thus far been primarily limited to their use as a means for providing commentaries and for maintaining open diaries.

In accordance with various embodiments, methods, systems, and computer program products are provided to, among other things, solicit and acquire subjective user state data including soliciting and acquiring data indicating incidence of at least one subjective user state associated with a user, the solicitation being indirectly or directly prompted based, at least in part on a hypothesis that links one or more subjective user states with one or more objective occurrences and in response to an incidence of at least one objective occurrence.

In various embodiments, a hypothesis may be defined by a sequential pattern that indicates or suggests a temporal or specific time sequencing relationship between one or more subjective user states and one or more objective occurrences. In some cases, the one or more subjective user states associated with the hypothesis may be based on past incidences of one or more subjective user states associated with a user, with multiple users, with a sub-group of the general population, or with the general population. Similarly, the one or more objective occurrences associated with the hypothesis may be based on past incidences of objective occurrences.

In some cases, a hypothesis may be formulated when it is determined that a particular pattern of events (e.g., incidences of one or more subjective user states and one or more objective occurrences) occurs repeatedly with respect to a particular user, a group of users, a subset of the general population, or the general population. For example, a hypothesis may be formulated that suggests or predicts that a person will likely have an upset stomach after eating a hot fudge sundae when it is determined that multiple users had reported having an upset stomach after eating a hot fudge sundae. In other cases, a hypothesis may be formulated based, at least in part, on a single pattern of events and historical data related to such events. For instance, a hypothesis may be formulated when a person reports that he had a stomach ache after eating a hot fudge sundae, and historical data suggests that a segment of the population may not be able to digest certain nutrients included in a hot fudge sundae (e.g., the hypothesis would suggest or indicate that the person may get stomach aches whenever the person eats a hot fudge sundae).

The subjective user state data to be acquired by the methods, systems, and the computer program products may include data indicating the incidence of at least one subjective user state associated with a user. Such subjective user state data together with objective occurrence data including data indicating incidence of at least one objective occurrence may then be correlated. The results of the correlation may be presented in a variety of different forms and may, in some cases, confirm the veracity of the hypothesis. The results of the correlation, in various embodiments, may be presented to the user, to other users, or to one or more third parties as will further described herein.

In some embodiments, the correlation of the acquired subjective user state data with the objective occurrence data may facilitate in determining a causal relationship between at least one objective occurrence (e.g., cause) and at least one subjective user state (e.g., result). For example, determining whenever a user eats a banana the user always or sometimes feels good. Note that an objective occurrence does not need to occur prior to a corresponding subjective user state but instead, may occur subsequent or at least partially concurrently with the incidence of the subjective user state. For example, a person may become “gloomy” (e.g., subjective user state) whenever it is about to rain (e.g., objective occurrence) or a person may become gloomy while (e.g., concurrently) it is raining

As briefly described earlier, the subjective user state data to be acquired may include data that indicate the incidence or occurrence of at least one subjective user state associated with a user. In situations where the subjective user state data to be acquired indicates multiple subjective user states, each of the subjective user states indicated by the acquired subjective user state data may be solicited, while in other embodiments, only one or a subset of the subjective user states indicated by the acquired subjective user state data may be solicited. A “subjective user state” is in reference to any subjective user state or status associated with a user (e.g., a blogger or microblogger) at any moment or interval in time that only the user can typically indicate or describe. Such states include, for example, the subjective mental state of the user (e.g., user is feeling sad), the subjective physical state (e.g., physical characteristic) of the user that only the user can typically indicate (e.g., a backache or an easing of a backache as opposed to blood pressure which can be reported by a blood pressure device and/or a third party), and the subjective overall state of the user (e.g., user is “good”).

Examples of subjective mental states include, for example, happiness, sadness, depression, anger, frustration, elation, fear, alertness, sleepiness, and so forth. Examples of subjective physical states include, for example, the presence, easing, or absence of pain, blurry vision, hearing loss, upset stomach, physical exhaustion, and so forth. Subjective overall states may include any subjective user states that cannot be easily categorized as a subjective mental state or as a subjective physical state. Examples of subjective overall states include, for example, the user “being good,” “bad,” “exhausted,” “lack of rest,” “wellness,” and so forth.

In contrast, “objective occurrence data,” as will be described herein, may include data that indicate incidence of at least one objective occurrence. In some embodiments, an objective occurrence may be any physical characteristic, event, happenings, or any other aspect that may be associated with, is of interest to, or may somehow impact a user that can be objectively reported by at least a third party or a sensor device. Note, however, that an objective occurrence does not have to be actually reported by a sensor device or by a third party, but instead, may be reported by the user himself or herself (e.g., via microblog entries). Examples of objectively reported occurrences that could be indicated by the objective occurrence data include, for example, a user's food, medicine, or nutraceutical intake, the user's location at any given point in time, a user's exercise routine, a user's physiological characteristics such as blood pressure, social or professional activities, the weather at a user's location, activities associated with third parties, occurrence of external events such as the performance of the stock market, and so forth.

The term “correlating” as will be used herein may be in reference to a determination of one or more relationships between at least two variables. Alternatively, the term “correlating” may merely be in reference to the linking or associating of the at least two variables. In the following exemplary embodiments, the first variable is subjective user state data that indicates at least one subjective user state and the second variable is objective occurrence data that indicates at least one objective occurrence. In embodiments where the subjective user state indicates multiple subjective user states, each of the subjective user states indicated by the subjective user state data may represent different incidences of the same or similar type of subjective user state (e.g., happiness). Alternatively, the subjective user state data may indicate multiple subjective user states that represent different incidences of different types of subjective user states (e.g., happiness and sadness).

Similarly, in some embodiments where the objective occurrence data may indicate multiple objective occurrences, each of the objective occurrences indicated by the objective occurrence data may represent different incidences of the same or similar type of objective occurrence (e.g., exercising). In alternative embodiments, however, each of the objective occurrences indicated by the objective occurrence data may represent different incidences of different types of objective occurrence (e.g., user exercising and user resting).

Various techniques may be employed for correlating subjective user state data with objective occurrence data in various alternative embodiments. For example, in some embodiments, the correlation of the objective occurrence data with the subjective user state data may be accomplished by determining a sequential pattern associated with at least one subjective user state indicated by the subjective user state data and at least one objective occurrence indicated by the objective occurrence data. In other embodiments, the correlation of the objective occurrence data with the subjective user state data may involve determining multiple sequential patterns associated with multiple subjective user states and multiple objective occurrences.

A sequential pattern, as will be described herein, may define time and/or temporal relationships between two or more events (e.g., one or more subjective user states and one or more objective occurrences). In order to determine a sequential pattern, subjective user state data including data indicating incidence of at least one subjective user state associated with a user may be solicited, the solicitation being prompted based, at least in part, on a hypothesis linking one or more subjective user states with one or more objective occurrences and in response, at least in part, to an incidence of at least one objective occurrence.

For example, suppose a hypothesis suggests that a user or a group of users tend to be depressed whenever the weather is bad (e.g., cloudy or overcast weather), the hypothesis being formed, for example, based at least in part on reported past events (e.g., reported past subjective user states of a user or a group of users and reported past objective occurrences). Then upon the weather turning bad, and based at least in part on the hypothesis, subjective user state data including data indicating incidence of at least one subjective user state associated with a user may be solicited from, for example, the user (or from other sources such as third party sources). If, after soliciting for the subjective user state data, data indeed is acquired that indicates that the user felt depressed when the weather turned bad, this may confirm the veracity of the hypothesis. On the other hand, if the data that is acquired after the solicitation indicates that the user was happy when the weather turned bad, this may indicate that there is a weaker correlation or link between depression and bad weather.

As briefly described above, a hypothesis may be represented by a sequential pattern that may merely indicate or represent the temporal relationship or relationships between at least one subjective user state and at least one objective occurrence (e.g., whether the incidence or occurrence of at least one subjective user state occurred before, after, or at least partially concurrently with the incidence of the at least one objective occurrence). In alternative implementations, and as will be further described herein, a sequential pattern may indicate a more specific time relationship between the incidences of one or more subjective user states and the incidences of one or more objective occurrences. For example, a sequential pattern may represent the specific pattern of events (e.g., one or more objective occurrences and one or more subjective user states) that occurs along a timeline.

The following illustrative example is provided to describe how a sequential pattern associated with at least one subjective user state and at least one objective occurrence may be determined based, at least in part, on the temporal relationship between the incidence of at least one subjective user state and the incidence of at least one objective occurrence in accordance with some embodiments. For these embodiments, the determination of a sequential pattern may initially involve determining whether the incidence of the at least one subjective user state occurred within some predefined time increment from the incidence of the one objective occurrence. That is, it may be possible to infer that those subjective user states that did not occur within a certain time period from the incidence of an objective occurrence are not related or are unlikely related to the incidence of that objective occurrence.

For example, suppose a user during the course of a day eats a banana and also has a stomach ache sometime during the course of the day. If the consumption of the banana occurred in the early morning hours but the stomach ache did not occur until late that night, then the stomach ache may be unrelated to the consumption of the banana and may be disregarded. On the other hand, if the stomach ache had occurred within some predefined time increment, such as within 2 hours of consumption of the banana, then it may be concluded that there is a link between the stomach ache and the consumption of the banana. If so, a temporal relationship between the consumption of the banana and the occurrence of the stomach ache may be established. Such a temporal relationship may be represented by a sequential pattern. Such a sequential pattern may simply indicate that the stomach ache (e.g., a subjective user state) occurred after (rather than before or concurrently) the consumption of banana (e.g., an objective occurrence).

Other factors may also be referenced and examined in order to determine a sequential pattern and whether there is a relationship (e.g., causal relationship) between an incidence of an objective occurrence and an incidence of a subjective user state. These factors may include, for example, historical data (e.g., historical medical data such as genetic data or past history of the user or historical data related to the general population regarding, for example, stomach aches and bananas) as briefly described above.

In some implementations, a sequential pattern may be determined for multiple subjective user states and multiple objective occurrences. Such a sequential pattern may particularly map the exact temporal or time sequencing of the various events (e.g., subjective user states and/or objective occurrences). The determined sequential pattern may then be used to provide useful information to the user and/or third parties.

The following is another illustrative example of how subjective user state data may be correlated with objective occurrence data by determining multiple sequential patterns and comparing the sequential patterns with each other. Suppose, for example, a user such as a microblogger reports that the user ate a banana on a Monday. The consumption of the banana, in this example, is a reported incidence of a first objective occurrence associated with the user. The user then reports that 15 minutes after eating the banana, the user felt very happy. The reporting of the emotional state (e.g., felt very happy) is, in this example, a reported incidence of a first subjective user state. Thus, the reported incidence of the first objective occurrence (e.g., eating the banana) and the reported incidence of the first subjective user state (user felt very happy) on Monday may be represented by a first sequential pattern.

On Tuesday, the user reports that the user ate another banana (e.g., a second objective occurrence associated with the user). The user then reports that 20 minutes after eating the second banana, the user felt somewhat happy (e.g., a second subjective user state). Thus, the reported incidence of the second objective occurrence (e.g., eating the second banana) and the reported incidence of the second subjective user state (user felt somewhat happy) on Tuesday may be represented by a second sequential pattern. Under this scenario, the first sequential pattern may represent a hypothesis that links feeling happy or very happy (e.g., a subjective user state) with eating a banana (e.g., an objective occurrence). Alternatively, the first sequential pattern may merely represent historical data (e.g., historical sequential pattern). Note that in this example, the occurrences of the first subjective user state and the second subjective user state may be indicated by subjective user state data while the occurrences of the first objective occurrence and the second objective occurrence may be indicated by objective occurrence data.

In a slight variation of the above example, suppose the user had forgotten to report for Tuesday the feeling of being somewhat happy but does report consuming the second banana on Tuesday. This may result in the user being asked, based at least in part on the reporting of the user consuming the banana on Tuesday, and based at least in part on the hypothesis, as to how the user felt on Tuesday or how the user felt after eating the banana on Tuesday. Upon the user indicating feeling somewhat happy on Tuesday, a second sequential pattern may be determined.

In any event, by comparing the first sequential pattern with the second sequential pattern, the subjective user state data may be correlated with the objective occurrence data. Such a comparison may confirm the veracity of the hypothesis. In some implementations, the comparison of the first sequential pattern with the second sequential pattern may involve trying to match the first sequential pattern with the second sequential pattern by examining certain attributes and/or metrics. For example, comparing the first subjective user state (e.g., user felt very happy) of the first sequential pattern with the second subjective user state (e.g., user felt somewhat happy) of the second sequential pattern to see if they at least substantially match or are contrasting (e.g., being very happy in contrast to being slightly happy or being happy in contrast to being sad). Similarly, comparing the first objective occurrence (e.g., eating a banana) of the first sequential pattern may be compared to the second objective occurrence (e.g., eating of another banana) of the second sequential pattern to determine whether they at least substantially match or are contrasting.

A comparison may also be made to determine if the extent of time difference (e.g., 15 minutes) between the first subjective user state (e.g., user being very happy) and the first objective occurrence (e.g., user eating a banana) matches or are at least similar to the extent of time difference (e.g., 20 minutes) between the second subjective user state (e.g., user being somewhat happy) and the second objective occurrence (e.g., user eating another banana). These comparisons may be made in order to determine whether the first sequential pattern matches the second sequential pattern. A match or substantial match would suggest, for example, that a subjective user state (e.g., happiness) is linked to a particular objective occurrence (e.g., consumption of banana). In other words, confirming the hypothesis that happiness may be linked to the consumption of bananas.

As briefly described above, the comparison of the first sequential pattern with the second sequential pattern may include a determination as to whether, for example, the respective subjective user states and the respective objective occurrences of the sequential patterns are contrasting subjective user states and/or contrasting objective occurrences. For example, suppose in the above example the user had reported that the user had eaten a whole banana on Monday and felt very energetic (e.g., first subjective user state) after eating the whole banana (e.g., first objective occurrence). Suppose that the user also reported that on Tuesday he ate a half a banana instead of a whole banana and only felt slightly energetic (e.g., second subjective user state) after eating the half banana (e.g., second objective occurrence). In this scenario, the first sequential pattern (e.g., feeling very energetic after eating a whole banana) may be compared to the second sequential pattern (e.g., feeling slightly energetic after eating only a half of a banana) to at least determine whether the first subjective user state (e.g., being very energetic) and the second subjective user state (e.g., being slightly energetic) are contrasting subjective user states. Another determination may also be made during the comparison to determine whether the first objective occurrence (eating a whole banana) is in contrast with the second objective occurrence (e.g., eating a half of a banana).

In doing so, an inference may be made that eating a whole banana instead of eating only a half of a banana makes the user happier or eating more banana makes the user happier. Thus, the word “contrasting” as used here with respect to subjective user states refers to subjective user states that are the same type of subjective user states (e.g., the subjective user states being variations of a particular type of subjective user states such as variations of subjective mental states). Thus, for example, the first subjective user state and the second subjective user state in the previous illustrative example are merely variations of subjective mental states (e.g., happiness). Similarly, the use of the word “contrasting” as used here with respect to objective occurrences refers to objective states that are the same type of objective occurrences (e.g., consumption of food such as banana).

As those skilled in the art will recognize, a stronger correlation between the subjective user state data and the objective occurrence data could be obtained if a greater number of sequential patterns (e.g., if there was a third sequential pattern, a fourth sequential pattern, and so forth, that indicated that the user became happy or happier whenever the user ate bananas) are used as a basis for the correlation. Note that for ease of explanation and illustration, each of the exemplary sequential patterns to be described herein will be depicted as a sequential pattern of an incidence of a single subjective user state and an incidence of a single objective occurrence. However, those skilled in the art will recognize that a sequential pattern, as will be described herein, may also be associated with incidences or occurrences of multiple objective occurrences and/or multiple subjective user states. For example, suppose the user had reported that after eating a banana, he had gulped down a can of soda. The user then reported that he became happy but had an upset stomach. In this example, the sequential pattern associated with this scenario will be associated with two objective occurrences (e.g., eating a banana and drinking a can of soda) and two subjective user states (e.g., user having an upset stomach and feeling happy).

In some embodiments, and as briefly described earlier, the sequential patterns derived from subjective user state data and objective occurrence data may be based on temporal relationships between objective occurrences and subjective user states. For example, whether a subjective user state occurred before, after, or at least partially concurrently with an objective occurrence. For instance, a plurality of sequential patterns derived from subjective user state data and objective occurrence data may indicate that a user always has a stomach ache (e.g., subjective user state) after eating a banana (e.g., first objective occurrence).

FIGS. 6-1a and 6-1b illustrate an example environment in accordance with various embodiments. In the illustrated environment, an exemplary system 6-100 may include at least a computing device 6-10 (see FIG. 6-1b). The computing device 6-10, which may be a server (e.g., network server) or a standalone device, may be employed in order to, among other things, acquire objective occurrence data 6-70* including data indicating occurrence of at least one objective occurrence, to solicit and acquire subjective user state data 6-60 including data indicating incidence of at least one subjective user state 6-60a associated with a user 6-20*, and to correlate the subjective user state data 6-60 with the objective occurrence data 6-70*. In embodiments in which the computing device 6-10 is a server, the exemplary system 6-100 may also include a mobile device 6-30 to at least solicit and acquire the subjective user state data 6-60 including the data indicating incidence of at least one subjective user state 6-60a in response to, for example, a request made by the computing device 6-10 for subjective user state data 6-60. Note that in the following, “*” indicates a wildcard. Thus, user 6-20* may indicate a user 6-20a or a user 6-20b of FIGS. 6-1a and 6-1b.

As previously indicated, in some embodiments, the computing device 6-10 may be a network server in which case the computing device 6-10 may communicate with a user 6-20a via a mobile device 6-30 and through a wireless and/or wired network 6-40. A network server, as will be described herein, may be in reference to a server located at a single network site or located across multiple network sites or a conglomeration of servers located at multiple network sites. The mobile device 6-30 may be a variety of computing/communication devices including, for example, a cellular phone, a personal digital assistant (PDA), a laptop, a desktop, or other types of computing/communication device that can communicate with the computing device 6-10.

In alternative embodiments, the computing device 6-10 may be a standalone computing device 6-10 (or simply “standalone device”) that communicates directly with a user 6-20b. For these embodiments, the computing device 6-10 may be any type of handheld device such as a cellular telephone, a PDA, or other types of computing/communication devices such as a laptop computer, a desktop computer, and so forth. In various embodiments, the computing device 6-10 (as well as the mobile device 6-30) may be a peer-to-peer network component device. In some embodiments, the computing device 6-10 may operate via a web 2.0 construct.

In embodiments where the computing device 6-10 is a server, the computing device 6-10 may solicit and acquire the subjective user state data 6-60 indirectly from a user 6-20a via a network interface 6-120 and via mobile device 6-30. In alternative embodiments in which the computing device 6-10 is a local device such as a handheld device (e.g., cellular telephone, personal digital assistant, etc.), the subjective user state data 6-60 may be directly obtained from a user 6-20b via a user interface 6-122. As will be further described, the computing device 6-10 may acquire the objective occurrence data 6-70* from one or more alternative sources.

In various embodiments, and regardless of whether the computing device 6-10 is a server or a standalone device, the computing device 6-10 may have access to at least one hypothesis 6-71. For example, in some situations, a hypothesis 6-71 may have been generated based on reported past events including past incidences of one or more subjective user states (which may be associated with a user 6-20*, a group of users 6-20*, a portion of the general population, or the general population) and past incidences of one or more objective occurrences. Such a hypothesis 6-71, in some instances, may be stored in a memory 6-140 to be easily accessible.

For ease of illustration and explanation, the following systems and operations to be described herein will be generally described in the context of the computing device 6-10 being a network server. However, those skilled in the art will recognize that these systems and operations may also be implemented when the computing device 6-10 is a standalone device such as a handheld device that may communicate directly with a user 6-20b.

The computing device 6-10, in various implementations, may be configured to solicit subjective user state data 6-60 including soliciting data indicating incidence of at least one subjective user state 6-60a associated with a user 6-20a from the user 6-20a via the mobile device 6-30. The solicitation of the data indicating incidence of at least one subjective user state 6-60a may be based, at least in part, on a hypothesis 6-71 and in response, at least in part, to an incidence of at least one objective occurrence. In the case where the computing device 6-10 is a server, the computing device, based at least in part, on the hypothesis 6-71 and in response to the incidence of the at least one objective occurrence, may generate and transmit a solicitation or a request for the data indicating incidence of at least one subjective user state 6-60a to the mobile device 6-30. The mobile device 6-30, in response, may either directly provide the data indicating incidence of at least one subjective user state 6-60a (if it already has such data) or may solicit such data from the user 6-20a in order to pass along such data to the computing device 6-10.

In the case where the computing device 6-10 is a standalone device, the computing device 6-10, may be configured to solicit subjective user state data 6-60 including soliciting data indicating incidence of at least one subjective user state 6-60a associated with a user 6-20b directly from a user 6-20b via a user interface 6-122. After soliciting for the subjective user state data 6-60 including the data indicating incidence of at least one subjective user state 6-60a, the computing device 6-10 (e.g., either in the case where the computing device 6-10 is a server or in the case where the computing device 6-10 is a standalone device) may be further designed to acquire the data indicating incidence of at least one subjective user state 6-60a as well as to acquire other data indicating other incidences of subjective user states associated with a user 6-20* (e.g., data indicating incidence of at least a second subjective user state 6-60b, and so forth) from the user 6-20* via the mobile device 6-30 or via the user interface 6-122.

Examples of subjective user states that may be indicated by the subjective user state data 6-60 include, for example, subjective mental states of a user 6-20* (e.g., user 6-20* is sad or angry), subjective physical states of the user 6-20* (e.g., physical or physiological characteristic of the user 6-20* such as the presence, absence, elevating, or easing of a pain), subjective overall states of the user 6-20* (e.g., user 6-20* is “well”), and/or other subjective user states that only the user 6-20* can typically indicate.

In some implementations, the computing device 6-10 may also be configured to acquire objective occurrence data 6-70* including data indicating incidence of at least one objective occurrence via a network interface 6-120 or via user interface 6-122 (in the case where the computing device 6-10 is a standalone device). In some implementations, the objective occurrence data 6-70* to be acquired may further include additional data such as data indicating incidences of one or more additional objective occurrences (e.g., data indicating occurrence of at least a second objective occurrence). The objective occurrence data 6-70* may be provided by a user 6-20*, by one or more third party sources 6-50 (e.g., one or more third parties), or by one or more sensors 6-35.

For example, in some embodiments, objective occurrence data 6-70a may be acquired from one or more third party sources 6-50. Examples of third party sources 6-50 include, for example, other users, medical entities such as medical or dental clinics and hospitals, content providers, employers, fitness centers, social organizations, and so forth.

In some embodiments, objective occurrence data 6-70b may be acquired from one or more sensors 6-35 that may be designed for sensing or monitoring various aspects associated with the user 6-20a (or user 6-20b). For example, in some implementations, the one or more sensors 6-35 may include a global positioning system (GPS) device for determining the location of the user 6-20a and/or a physical activity sensor for measuring physical activities of the user 6-20a. Examples of a physical activity sensor include, for example, a pedometer for measuring physical activities of the user 6-20a. In certain implementations, the one or more sensors 6-35 may include one or more physiological sensor devices for measuring physiological characteristics of the user 6-20a. Examples of physiological sensor devices include, for example, a blood pressure monitor, a heart rate monitor, a glucometer, and so forth. In some implementations, the one or more sensors 6-35 may include one or more image capturing devices such as a video or digital camera.

In some embodiments, objective occurrence data 6-70c may be acquired from a user 6-20a via the mobile device 6-30 (or from user 6-20b via user interface 6-122). For these embodiments, the objective occurrence data 6-70c may be in the form of blog entries (e.g., microblog entries), status reports, or other types of electronic entries (e.g., diary or calendar entries) or messages. In various implementations, the objective occurrence data 6-70c acquired from a user 6-20* may indicate, for example, activities (e.g., exercise or food or medicine intake) performed by the user 6-20*, certain physical characteristics (e.g., blood pressure or location) associated with the user 6-20*, or other aspects associated with the user 6-20* that the user 6-20* can report objectively. The objective occurrence data 6-70c may be in the form of a text data, audio or voice data, or image data.

In various embodiments, after acquiring the subjective user state data 6-60 including data indicating incidence of at least one subjective user state 6-60a and the objective occurrence data 6-70* including data indicating incidence of at least one objective occurrence, the computing device 6-10 may be configured to correlate the acquired subjective user state data 6-60 with the acquired objective occurrence data 6-70* by, for example, determining whether there is a sequential relationship between the one or more subjective user states as indicated by the acquired subjective user state data 6-60 and the one or more objective occurrences indicated by the acquired objective occurrence data 6-70*.

In some embodiments, and as will be further explained in the operations and processes to be described herein, the computing device 6-10 may be further configured to present one or more results of correlation. In various embodiments, the one or more correlation results 6-80 may be presented to a user 6-20* and/or to one or more third parties in various forms (e.g., in the form of an advisory, a warning, a prediction, and so forth). The one or more third parties may be other users 6-20* (e.g., microbloggers), health care providers, advertisers, and/or content providers.

As illustrated in FIG. 6-1b, computing device 6-10 may include one or more components and/or sub-modules. As those skilled in the art will recognize, these components and sub-modules may be implemented by employing hardware (e.g., in the form of circuitry such as application specific integrated circuit or ASIC, field programmable gate array or FPGA, or other types of circuitry), software, a combination of both hardware and software, or a general purpose computing device executing instructions included in a signal-bearing medium. In various embodiments, computing device 6-10 may include a subjective user state data solicitation module 6-101, a subjective user state data acquisition module 6-102, an objective occurrence data acquisition module 6-104, a correlation module 6-106, a presentation module 6-108, a network interface 6-120 (e.g., network interface card or NIC), a user interface 6-122 (e.g., a display monitor, a touchscreen, a keypad or keyboard, a mouse, an audio system including a microphone and/or speakers, an image capturing system including digital and/or video camera, and/or other types of interface devices), one or more applications 6-126 (e.g., a web 2.0 application, a voice recognition application, and/or other applications), and/or memory 6-140, which may include at least one hypothesis 6-71 and historical data 6-72.

FIG. 6-2a illustrates particular implementations of the subjective user state data solicitation module 6-101 of the computing device 6-10 of FIG. 6-1b. The subjective user state data solicitation module 6-101 may be configured to solicit at least some subjective user state data 6-60 including soliciting data indicating incidence of at least one subjective user state 6-60a associated with a user 6-20*. In various implementations, the solicitation of the data indicating incidence of at least one subjective user state 6-60a may be prompted based, at least in part, on a hypothesis 6-71 that links one or more objective occurrences with one or more subjective user states and in response, at least in part, to incidence of at least one objective occurrence. For example, if an occurrence or incidence of an objective occurrence (e.g., consumption of alcohol by a user 6-20*) has been reported, and if the hypothesis 6-71 links the same type of objective occurrence (e.g., consuming alcohol) to a subjective user state (e.g., a hangover), then the solicitation of the data indicating incidence of at least one subjective user state 6-60a may be to solicit data that would indicate the subjective user state of the user 6-20* following the consumption of the alcohol by the user 6-20*.

The subjective user state data solicitation module 6-101 may include one or more sub-modules in various alternative implementations. For example, in various implementations, the subjective user state data solicitation module 6-101 may include a requesting module 6-202 configured to request for data indicating incidence of at least one subjective user state 6-60a associated with a user 6-20*. The requesting module 6-202 may further include one or more sub-modules. For example, in some implementations, such as when the computing device 6-10 is a standalone device, the requesting module 6-202 may include a user interface requesting module 6-204 configured to request for data indicating incidence of at least one subjective user state 6-60a associated with a user 6-20b via a user interface 6-122. The user interface requesting module 6-204, in some cases, may further include a request indication module 6-205 configured to indicate a request for data indicating incidence of at least one subjective user state 6-60a associated with a user 6-20b via the user interface 6-122 (e.g., indicating through at least a display system including a display monitor or touchscreen, or an audio system including a speaker).

In some implementations, such as when the computing device 6-10 is a server, the requesting module 6-202 may include a network interface requesting module 6-206 configured to request for data indicating incidence of at least one subjective user state 6-60a associated with a user 6-20a via a network interface 6-120. The network interface requesting module 6-206 may further include one or more sub-modules in various alternative implementations. For example, in some implementations, the network interface requesting module 6-206 may include a request transmission module 6-207 configured to transmit a request to be provided with data indicating incidence of at least one subjective user state 6-60a associated with a user 6-20a. Alternatively or in the same implementations, the network interface requesting module 6-206 may include a request access module 6-208 configured to transmit data indicating incidence of at least one subjective user state 6-60a associated with the user 6-20a a request to have access to data indicating incidence of at least one subjective user state 6-60a associated with a user 6-20a.

In the same or different implementations, the network interface requesting module 6-206 may include a configuration module 6-209 designed to configure (e.g., remotely configure) one or more remote devices (e.g., a remote network server, a mobile device 6-30, or some other network device) to provide data indicating incidence of at least one subjective user state 6-60a associated with a user 6-20a. In the same or different implementations, the network interface requesting module 6-206 may include a directing/instructing module 6-210 configured to direct or instruct a remote device (e.g., transmitting directions or instructions to the remote device such as a remote network server or the mobile device 6-30) to provide data indicating incidence of at least one subjective user state 6-60a associated with a user 6-20a.

The requesting module 6-202 may include other sub-modules in various alternative implementations. These sub-modules may be included with the requesting module 6-202 regardless of whether the computing device 6-10 is a server or a standalone device. For example, in some implementations, the requesting module 6-202 may include a motivation provision module 6-212 configured to provide, among other things, a motivation for requesting for data indicating incidence of at least one subjective user state 6-60a associated with a user 6-20*. In the same or different implementations, the requesting module 6-202 may include a selection request module 6-214 configured to, among other things, request a user 6-20* for a selection of a subjective user state from a plurality of indicated alternative subjective user states (e.g., asking the user 6-20* through the user interface 6-122* to select from alternative choices of “happy,” “sad,” “in pain,” and “upset stomach”).

In the same or different implementations, the requesting module 6-202 may include a confirmation request module 6-216 configured to request confirmation of an incidence of at least one subjective user state (e.g., asking a user 6-20* through the user interface 6-122* whether the user feels “well”) associated with a user 6-20*. In the same or different implementations, the requesting module 6-202 may include a time/temporal element request module 6-218 configured to, among other things, request for an indication of a time or temporal element associated with an incidence of at least one subjective user state associated with the user 6-20* (e.g., asking the user 6-20* via the user interface 6-122 whether the user 6-20* felt tired after lunch?).

In various implementations, the subjective user state data solicitation module 6-101 of FIG. 6-2a may include a hypothesis referencing module 6-220 configured to, among other things, reference at least one hypothesis 6-71, which in some cases, may be stored in memory 6-140.

FIG. 6-2b illustrates particular implementations of the subjective user state data acquisition module 6-102 of the computing device 6-10 of FIG. 6-1b. In brief, the subjective user state data acquisition module 6-102 may be designed to, among other things, acquire subjective user state data 6-60 including data indicating at least one subjective user state 6-60a associated with a user 6-20*. In various embodiments, the subjective user state data acquisition module 6-102 may include a subjective user state data reception module 6-224 configured to receive subjective user state data 6-60. In some implementations, the subjective user state data reception module 6-224 may further include a user interface reception module 6-226 configured to receive, via a user interface 6-122, subjective user state data 6-60 including data indicating incidence of at least one subjective user state 6-60a associated with a user 6-20*. In the same or different implementations, the subjective user state data reception module 6-224 may include a network interface reception module 6-227 configured to receive, via a network interface 6-120, subjective user state data 6-60 including data indicating incidence of at least one subjective user state 6-60a associated with a user 6-20*.

The subjective user state data acquisition module 6-102, in various implementations, may include a time data acquisition module 6-228 configured to acquire (e.g., receive or generate) time and/or temporal elements associated with one or more subjective user states associated with a user 6-20*. In some implementations, the time data acquisition module 6-228 may include a time stamp acquisition module 6-230 for acquiring (e.g., acquiring either by receiving or by generating) one or more time stamps associated with one or more subjective user states associated with a user 6-20*. In the same or different implementations, the time data acquisition module 6-228 may include a time interval acquisition module 6-231 for acquiring (e.g., either by receiving or generating) indications of one or more time intervals associated with one or more subjective user states associated with a user 6-20*. In the same or different implementations, the time data acquisition module 6-228 may include a temporal relationship acquisition module 6-232 for acquiring indications of temporal relationships between objective occurrences and subjective user states (e.g., an indication that a subjective user state associated with a user 6-20* occurred before, after, or at least partially concurrently with incidence of an objective occurrence).

FIG. 6-2c illustrates particular implementations of the objective occurrence data acquisition module 6-104 of the computing device 6-10 of FIG. 6-1b. In brief, the objective occurrence data acquisition module 6-104 may be configured to, among other things, acquire objective occurrence data 6-70* including data indicating incidence of at least one objective occurrence. As further illustrated, in some implementations, the objective occurrence data acquisition module 6-104 may include an objective occurrence data reception module 6-234 configured to, among other things, receive objective occurrence data 6-70* from a user 6-20*, from one or more third party sources 6-50 (e.g., one or more third parties), or from one or more sensors 6-35.

The objective occurrence data reception module 6-234, in turn, may further include one or more sub-modules. For example, in some implementations, such as when the computing device 6-10 is a standalone device, the objective occurrence data reception module 6-234 may include a user interface data reception module 6-235 configured to receive objective occurrence data 6-70c via a user interface 6-122 (e.g., a keyboard, a mouse, a touchscreen, a microphone, an image capturing device such as a digital camera, and so forth). In some cases, the objective occurrence data 6-70c to be received via the user interface 6-122 may be provided, at least in part, by a user 6-20b. In some implementations, such as when the computing device 6-10 is a server, the objective occurrence data reception module 6-234 may include a network interface data reception module 6-236 configured to, among other things, receive objective occurrence data 6-70* from at least one of a wireless network or a wired network 6-40.

The objective occurrence data acquisition module 6-104 may include other sub-modules in various implementations. For example, in some implementations, the objective occurrence data acquisition module 6-104 may include a time data acquisition module 6-238 configured to acquire time and/or temporal elements associated with one or more objective occurrences. For these embodiments, the time and/or temporal elements (e.g., time stamps, time interval indicators, and/or temporal relationship indicators) acquired by the time data acquisition module 6-238 may be useful for, among other things, determining one or more sequential patterns.

In some implementations, the time data acquisition module 6-238 may include a time stamp acquisition module 6-240 configured to acquire (e.g., acquire either by receiving or by generating) one or more time stamps associated with one or more objective occurrences. In the same or different implementations, the time data acquisition module 6-238 may include a time interval acquisition module 6-241 configured to acquire (e.g., acquire either by receiving or by generating) one or more indicators of time intervals associated with one or more objective occurrences.

Turning now to FIG. 6-2d illustrating particular implementations of the correlation module 6-106 of the computing device 6-10 of FIG. 6-1b. The correlation module 6-106 may be configured to, among other things, correlate subjective user state data 6-60 with objective occurrence data 6-70* based, at least in part, on a determination of at least one sequential pattern of at least one objective occurrence and at least one subjective user state. In various embodiments, the correlation module 6-106 may include a sequential pattern determination module 6-242 configured to determine one or more sequential patterns of one or more incidences of subjective user states and one or more incidences of objective occurrences.

The sequential pattern determination module 6-242, in various implementations, may include one or more sub-modules that may facilitate in the determination of one or more sequential patterns. As depicted, the one or more sub-modules that may be included in the sequential pattern determination module 6-242 may include, for example, a “within predefined time increment determination” module 6-244, a temporal relationship determination module 6-246, a subjective user state and objective occurrence time difference determination module 6-245, and/or a historical data referencing module 6-243. In brief, the within predefined time increment determination module 6-244 may be configured to determine whether an incidence of at least one subjective user state associated with a user 6-20* occurred within a predefined time increment from an incidence of at least one objective occurrence. For example, determining whether a user 6-20* “feeling bad” (i.e., a subjective user state) occurred within ten hours (i.e., predefined time increment) of eating a large chocolate sundae (i.e., an objective occurrence). Such a process may be used in order to filter out events that are likely not related or to facilitate in determining the strength of correlation between subjective user state data 6-60 and objective occurrence data 6-70*. For example, if the user 6-20* “feeling bad” occurred more than 10 hours after eating the chocolate sundae, then this may indicate a weaker correlation between a subjective user state (e.g., feeling bad) and an objective occurrence (e.g., eating a chocolate sundae).

The temporal relationship determination module 6-246 of the sequential pattern determination module 6-242 may be configured to determine the temporal relationships between one or more incidences of subjective user states associated with a user 6-20* and one or more incidences of objective occurrences. For example, this determination may entail determining whether an incidence of a particular subjective user state (e.g., sore back) occurred before, after, or at least partially concurrently with an incidence of a particular objective occurrence (e.g., sub-freezing temperature).

The subjective user state and objective occurrence time difference determination module 6-245 of the sequential pattern determination module 6-242 may be configured to determine the extent of time difference between an incidence of at least one subjective user state associated with a user 6-20* and an incidence of at least one objective occurrence. For example, determining how long after taking a particular brand of medication (e.g., objective occurrence) did a user 6-20* feel “good” (e.g., subjective user state).

The historical data referencing module 6-243 of the sequential pattern determination module 6-242 may be configured to reference historical data 6-72 in order to facilitate in determining sequential patterns. For example, in various implementations, the historical data 6-72 that may be referenced may include, for example, general population trends (e.g., people having a tendency to have a hangover after drinking or ibuprofen being more effective than aspirin for toothaches in the general population), medical information such as genetic, metabolome, or proteome information related to the user 6-20* (e.g., genetic information of the user 6-20* indicating that the user 6-20* is susceptible to a particular subjective user state in response to occurrence of a particular objective occurrence), or historical sequential patterns such as known sequential patterns of the general population or of the user 6-20* (e.g., people tending to have difficulty sleeping within five hours after consumption of coffee). In some instances, such historical data 6-72 may be useful in associating one or more incidences of subjective user states associated with a user 6-20* with one or more incidences of objective occurrences.

In some embodiments, the correlation module 6-106 may include a sequential pattern comparison module 6-248. As will be further described herein, the sequential pattern comparison module 6-248 may be configured to compare two or more sequential patterns with each other to determine, for example, whether the sequential patterns at least substantially match each other or to determine whether the sequential patterns are contrasting sequential patterns.

As depicted in FIG. 6-2d, in various implementations, the sequential pattern comparison module 6-248 may further include one or more sub-modules that may be employed in order to, for example, facilitate in the comparison of different sequential patterns. For example, in various implementations, the sequential pattern comparison module 6-248 may include one or more of a subjective user state equivalence determination module 6-250, an objective occurrence equivalence determination module 6-251, a subjective user state contrast determination module 6-252, an objective occurrence contrast determination module 6-253, a temporal relationship comparison module 6-254, and/or an extent of time difference comparison module 6-255. In some implementations, the sequential pattern comparison module 6-248 may be employed in order to, for example, confirm the veracity of a hypothesis 6-71.

The subjective user state equivalence determination module 6-250 of the sequential pattern comparison module 6-248 may be configured to determine whether subjective user states associated with different sequential patterns are at least substantially equivalent. For example, the subjective user state equivalence determination module 6-250 may determine whether a first subjective user state of a first sequential pattern is equivalent to a second subjective user state of a second sequential pattern. For instance, suppose a user 6-20* reports that on Monday he had a stomach ache (e.g., first subjective user state) after eating at a particular restaurant (e.g., a first objective occurrence), and suppose further that the user 6-20* again reports having a stomach ache (e.g., a second subjective user state) after eating at the same restaurant (e.g., a second objective occurrence) on Tuesday, then the subjective user state equivalence determination module 6-250 may be employed in order to compare the first subjective user state (e.g., stomach ache) with the second subjective user state (e.g., stomach ache) to determine whether they are equivalent. Note that in this example, the first sequential pattern may represent a hypothesis 6-71 linking a subjective user state (e.g., stomach ache) to an objective occurrence (e.g., eating at a particular restaurant).

In contrast, the objective occurrence equivalence determination module 6-251 of the sequential pattern comparison module 6-248 may be configured to determine whether objective occurrences of different sequential patterns are at least substantially equivalent. For example, the objective occurrence equivalence determination module 6-251 may determine whether a first objective occurrence of a first sequential pattern is equivalent to a second objective occurrence of a second sequential pattern. For instance, in the above example, the objective occurrence equivalence determination module 6-251 may compare eating at the particular restaurant on Monday (e.g., first objective occurrence) with eating at the same restaurant on Tuesday (e.g., second objective occurrence) in order to determine whether the first objective occurrence is equivalent to the second objective occurrence.

In some implementations, the sequential pattern comparison module 6-248 may include a subjective user state contrast determination module 6-252 that may be configured to determine whether subjective user states associated with different sequential patterns are contrasting subjective user states. For example, the subjective user state contrast determination module 6-252 may determine whether a first subjective user state of a first sequential pattern is a contrasting subjective user state from a second subjective user state of a second sequential pattern. To illustrate, suppose a user 6-20* reports that he felt very “good” (e.g., first subjective user state) after jogging for an hour (e.g., first objective occurrence) on Monday, but reports that he felt “bad” (e.g., second subjective user state) when he did not exercise (e.g., second objective occurrence) on Tuesday, then the subjective user state contrast determination module 6-245 may compare the first subjective user state (e.g., feeling good) with the second subjective user state (e.g., feeling bad) to determine that they are contrasting subjective user states.

In some implementations, the sequential pattern comparison module 6-248 may include an objective occurrence contrast determination module 6-253 that may be configured to determine whether objective occurrences of different sequential patterns are contrasting objective occurrences. For example, the objective occurrence contrast determination module 6-253 may determine whether a first objective occurrence of a first sequential pattern is a contrasting objective occurrence from a second objective occurrence of a second sequential pattern. For instance, in the previous example, the objective occurrence contrast determination module 6-253 may compare the “jogging” on Monday (e.g., first objective occurrence) with the “no jogging” on Tuesday (e.g., second objective occurrence) in order to determine whether the first objective occurrence is a contrasting objective occurrence from the second objective occurrence. Based on the contrast determination, an inference may be made that the user 6-20* may feel better by jogging rather than by not jogging at all.

In some embodiments, the sequential pattern comparison module 6-248 may include a temporal relationship comparison module 6-254 that may be configured to make comparisons between different temporal relationships of different sequential patterns. For example, the temporal relationship comparison module 6-254 may compare a first temporal relationship between a first subjective user state and a first objective occurrence of a first sequential pattern with a second temporal relationship between a second subjective user state and a second objective occurrence of a second sequential pattern in order to determine whether the first temporal relationship at least substantially matches the second temporal relationship.

For example, referring back to the earlier example, suppose the user 6-20* eating at the particular restaurant (e.g., first objective occurrence) and the subsequent stomach ache (e.g., first subjective user state) on Monday represents a first sequential pattern while the user 6-20* eating at the same restaurant (e.g., second objective occurrence) and the subsequent stomach ache (e.g., second subjective user state) on Tuesday represents a second sequential pattern. In this example, the occurrence of the stomach ache after (rather than before or concurrently) eating at the particular restaurant on Monday represents a first temporal relationship associated with the first sequential pattern while the occurrence of a second stomach ache after (rather than before or concurrently) eating at the same restaurant on Tuesday represents a second temporal relationship associated with the second sequential pattern. Under such circumstances, the temporal relationship comparison module 6-254 may compare the first temporal relationship to the second temporal relationship in order to determine whether the first temporal relationship and the second temporal relationship at least substantially match (e.g., stomach aches in both temporal relationships occurring after eating at the restaurant). Such a match may result in the inference that a stomach ache is associated with eating at the particular restaurant and may, in some instances, confirm the veracity of a hypothesis 6-71.

In some implementations, the sequential pattern comparison module 6-248 may include an extent of time difference comparison module 6-255 that may be configured to compare the extent of time differences between incidences of subjective user states and incidences of objective occurrences of different sequential patterns. For example, the extent of time difference comparison module 6-255 may compare the extent of time difference between incidence of a first subjective user state and incidence of a first objective occurrence of a first sequential pattern with the extent of time difference between incidence of a second subjective user state and incidence of a second objective occurrence of a second sequential pattern. In some implementations, the comparisons may be made in order to determine that the extent of time differences of the different sequential patterns at least substantially or proximately match.

In some embodiments, the correlation module 6-106 may include a strength of correlation determination module 6-256 for determining a strength of correlation between subjective user state data 6-60 and objective occurrence data 6-70* associated with a user 6-20*. In some implementations, the strength of correlation may be determined based, at least in part, on the results provided by the other sub-modules of the correlation module 6-106 (e.g., the sequential pattern determination module 6-242, the sequential pattern comparison module 6-248, and their sub-modules).

FIG. 6-2e illustrates particular implementations of the presentation module 6-108 of the computing device 6-10 of FIG. 6-1b. In various implementations, the presentation module 6-108 may be configured to present, for example, one or more results of the correlation operations performed by the correlation module 6-106. In some implementations, the presentation module 6-108 may include a network interface transmission module 6-258 configured to transmit one or more results of a correlation operation performed by the correlation module 6-106 via a network interface 6-120 (e.g., NIC). In the same or different implementations, the presentation module 6-108 may include a user interface indication module 6-259 configured to indicate one or more results of a correlation operation performed by the correlation module 6-106 via a user interface 6-122 (e.g., display monitor or audio system including a speaker).

The one or more results of a correlation operation performed by the correlation module 6-106 may be presented in different forms in various alternative embodiments. For example, in some implementations, the presentation of the one or more results may entail the presentation module 6-108 presenting to the user 6-20* (or some other third party) an indication of a sequential relationship between a subjective user state and an objective occurrence associated with the user 6-20* (e.g., “whenever you eat a banana, you have a stomach ache”). In alternative implementations, other ways of presenting the results of the correlation may be employed. For example, in various alternative implementations, a notification may be provided to notify past tendencies or patterns associated with a user 6-20*. In some implementations, a notification of a possible future outcome may be provided. In other implementations, a recommendation for a future course of action based on past patterns may be provided. These and other ways of presenting the correlation results will be described in the processes and operations to be described herein.

In order to present the one or more results of a correlation operation performed by the correlation module 6-106, the presentation module 6-108 may include one or more sub-modules. For example, in some implementations, the presentation module 6-108 may include a sequential relationship presentation module 6-260 configured to present an indication of a sequential relationship between at least one subjective user state of a user 6-20* and at least one objective occurrence. In the same or different implementations, the presentation module 6-108 may include a prediction presentation module 6-261 configured to present a prediction of a future subjective user state of a user 6-20* resulting from a future objective occurrence associated with the user 6-20*. In the same or different implementations, the prediction presentation module 6-261 may also be designed to present a prediction of a future subjective user state of a user 6-20* resulting from a past objective occurrence associated with the user 6-20*. In some implementations, the presentation module 6-108 may include a past presentation module 6-262 that is designed to present a past subjective user state of a user 6-20* in connection with a past objective occurrence associated with the user 6-20*.

In some implementations, the presentation module 6-108 may include a recommendation module 6-263 configured to present a recommendation for a future action based, at least in part, on the results of a correlation of subjective user state data 6-60 with objective occurrence data 6-70* as performed by the correlation module 6-106. In certain implementations, the recommendation module 6-262 may further include a justification module 6-264 for presenting a justification for the recommendation presented by the recommendation module 6-263. In some implementations, the presentation module 6-108 may include a strength of correlation presentation module 6-266 for presenting an indication of a strength of correlation between subjective user state data 6-60 and objective occurrence data 6-70*.

In various embodiments, the computing device 6-10 of FIG. 6-1b may include a network interface 6-120 that may facilitate in communicating with a user 6-20a, with one or more sensors 6-35, and/or with one or more third party sources 6-50. For example, in embodiments where the computing device 6-10 is a server, the computing device 6-10 may include a network interface 6-120 that may be configured to receive from the user 6-20a subjective user state data 6-60. In some embodiments, objective occurrence data 6-70a, 6-70b, and/or 6-70c may also be received through the network interface 6-120. Examples of a network interface 6-120 includes, for example, a network interface card (NIC).

The computing device 6-10 may also include a memory 6-140 for storing various data. For example, in some embodiments, memory 6-140 may be employed in order to store a hypothesis 6-71 and/or historical data 6-72. In some implementations, the historical data 6-72 may include historical subjective user state data of a user 6-20* that may indicate one or more past subjective user states of the user 6-20* and historical objective occurrence data that may indicate one or more past objective occurrences. In the same or different implementations, the historical data 6-72 may include historical medical data of a user 6-20* (e.g., genetic, metoblome, proteome information), population trends, historical sequential patterns derived from general population, and so forth.

In various embodiments, the computing device 6-10 may include a user interface 6-122 to communicate directly with a user 6-20b. For example, in embodiments in which the computing device 6-10 is a standalone device such as a handheld device (e.g., cellular telephone, PDA, and so forth), the user interface 6-122 may be configured to directly receive from the user 6-20b subjective user state data 6-60 and/or objective occurrence data 6-70*. In some implementations, the user interface 6-122 may also be designed to visually or audibly present the results of correlating subjective user state data 6-60 and objective occurrence data 6-70*. The user interface 6-122 may include, for example, one or more of a display monitor, a touch screen, a key board, a key pad, a mouse, an audio system including a microphone and/or one or more speakers, an imaging system including a digital or video camera, and/or other user interface devices.

FIG. 6-2f illustrates particular implementations of the one or more applications 6-126 of FIG. 6-1b. For these implementations, the one or more applications 6-126 may include, for example, one or more communication applications 6-267 such as a text messaging application and/or an audio messaging application including a voice recognition system application. In some implementations, the one or more applications 6-126 may include a web 2.0 application 6-268 to facilitate communication via, for example, the World Wide Web.

The various features and characteristics of the components, modules, and sub-modules of the computing device 6-10 presented thus far will be described in greater detail with respect to the processes and operations to be described herein. Note that the subjective user state data 6-60 may be in a variety of forms including, for example, text messages (e.g., blog entries, microblog entries, instant messages, text email messages, and so forth), audio messages, and/or images (e.g., an image capturing user's facial expression or gestures).

Referring to FIG. 6-2g illustrating particular implementations of the mobile device 6-30 of FIG. 6-1a. The mobile device 6-30 includes some modules that are the same as some of the modules that may be included in the computing device 6-10. These components may have the same features and perform the same or similar types of functions as those of their corresponding counterparts in the computing device 6-10. For example, and just like the computing device 6-10, the mobile device 6-30 may include a subjective user state data solicitation module 6-101′, a subjective user state data acquisition module 6-102′, an objective occurrence data acquisition module 6-104′, a presentation module 6-108′, a network interface 6-120′, a user interface 6-122′, one or more applications[s] 6-126′ (e.g., including a Web 2.0 application), and/or memory 6-140′ (including historical data 6-72′).

In various implementations, in addition to these components, the mobile device 6-30 may include a subjective user state data transmission module 6-160 that is configured to transmit (e.g., transmit via a wireless and/or wired network 6-40) subjective user state data 6-60 including data indicating incidence of at least one subjective user state 6-60a. In some implementations, the subjective user state data 6-60 may be transmitted to a network server such as computing device 6-10. In the same or different implementations, the mobile device 6-30 may include a correlation results reception module 6-162 that may be configured to receive, via a wireless and/or wired network 6-40, results of correlation of subjective user state data 6-60 with objective occurrence data 6-70*. In some implementations, such a correlation may have been performed at a network server (e.g., computing device 6-10).

FIG. 6-2h illustrates particular implementations of the subjective user state data solicitation module 6-101′ of the mobile device 6-30 of FIG. 6-2g. As depicted, the subjective user state data solicitation module 6-101′ may include some components that are the same or similar to some of the components that may be included in the subjective user state data solicitation module 6-101 of the computing device 6-10. For example, the subjective user state data solicitation module 6-101′ may include a requesting module 6-202′ that further includes a user interface requesting module 6-204′ (and a request indication module 6-205′ included with the user interface requesting module 6-204′), a motivation provision module 6-212′, a selection request module 6-214′, a confirmation request module 6-216′ and a time/temporal element request module 6-218′. These components may have the same features and perform the same functions as their counterparts in the computing device 6-10.

In addition, the subjective user state data solicitation module 6-101′ may include a request to solicit reception module 6-270 that may be configured to receive a request to solicit data indicating incidence of at least one subjective user state 6-60a associated with a user 6-20a. Such a request, in some implementations, may be remotely generated (e.g. remotely generated at the computing device 6-10) based, at least in part, on a hypothesis 6-71 and, in some cases, in response, at least in part, to an incidence of at least one objective occurrence.

FIG. 6-2i illustrates particular implementations of the subjective user state data acquisition module 6-102′ of the mobile device 6-30 of FIG. 6-2g. The subjective user state data acquisition module 6-102′ may include some components that are the same or similar to some of the components that may be included in the subjective user state data acquisition module 6-102 (see FIG. 6-2b) of the computing device 6-10. These components may perform the same or similar functions as their counterparts in the subjective user state data acquisition module 6-102 of the computing device 6-10. For example, the subjective user state data acquisition module 6-102′ may include a subjective user state data reception module 6-224′ and a time data acquisition module 6-228′. Similar to their counterparts in the computing device 6-10 and performing similar roles, the subjective user state data reception module 6-224′ may include a user interface reception module 6-226′ while the time data acquisition module 6-228′ may include a time stamp acquisition module 6-230′, a time interval acquisition module 6-231′, and/or a temporal relationship acquisition module 6-232′.

Referring to FIG. 6-2j illustrating particular implementations of the objective occurrence data acquisition module 6-104′ of the mobile device 6-30 of FIG. 6-2g. The objective occurrence data acquisition module 6-104′ may include the same or similar type of components that may be included in the objective occurrence data acquisition module 6-104 (see FIG. 6-2c) of the computing device 6-10. For example, the objective occurrence data acquisition module 6-104′ may include an objective occurrence data reception module 6-234′ (which may further include a user interface data reception module 6-235′ and/or a network interface data reception 6-236′) and a time data acquisition module 6-238′ (which may further include a time stamp acquisition module 6-240′ and/or a time interval acquisition module 6-241′).

FIG. 6-2k illustrates particular implementations of the presentation module 6-108′ of the mobile device 6-30 of FIG. 6-2g. In various implementations, the presentation module 6-108′ may include some of the same components that may be included in the presentation module 6-108 (see FIG. 6-2e) of the computing device 6-10. For example, the presentation module 6-108′ may include a user interface indication module 6-259′, a sequential relationship presentation module 6-260′, a prediction presentation module 6-261′, a past presentation module 6-262′, a recommendation module 6-263′ (which may further include a justification module 6-264′), and/or a strength of correlation presentation module 6-266′.

A more detailed discussion of these components (e.g., modules and interfaces) that may be included in the mobile device 6-30 and those that may be included in the computing device 6-10 will be provided with respect to the processes and operations to be described herein.

FIG. 6-3 illustrates an operational flow 6-300 representing example operations related to, among other things, hypothesis based solicitation and acquisition of subjective user state data 6-60 including at least data indicating incidence of at least one subjective user state 6-60a associated with a user 6-20*. In some embodiments, the operational flow 6-300 may be executed by, for example, the computing device 6-10, which may be a server or a standalone device. Alternatively, the operation flow may be executed by the mobile device 6-30 of FIG. 6-1b.

In FIG. 6-3 and in the following figures that include various examples of operational flows, discussions and explanations may be provided with respect to the above-described exemplary environment of FIGS. 6-1a and 6-1b, and/or with respect to other examples (e.g., as provided in FIGS. 6-2a-6-2k) and contexts. However, it should be understood that the operational flows may be executed in a number of other environments and contexts, and/or in modified versions of FIGS. 6-1a, 6-1b, and 6-2a-6-2k. Also, although the various operational flows are presented in the sequence(s) illustrated, it should be understood that the various operations may be performed in other orders than those which are illustrated, or may be performed concurrently.

Further, in FIG. 6-3 and in following figures, various operations may be depicted in a box-within-a-box manner. Such depictions may indicate that an operation in an internal box may comprise an optional example embodiment of the operational step illustrated in one or more external boxes. However, it should be understood that internal box operations may be viewed as independent operations separate from any associated external boxes and may be performed in any sequence with respect to all other illustrated operations, or may be performed concurrently.

In any event, after a start operation, the operational flow 6-300 may move to a subjective user state data solicitation operation 6-302 for soliciting, based at least in part on a hypothesis that links one or more objective occurrences with one or more subjective user states and in response at least in part to an incidence of at least one objective occurrence, subjective user state data including data indicating incidence of at least one subjective user state associated with a user. For instance, the subjective user state data solicitation module 6-101 of the computing device 6-10 or the subjective user state data solicitation module 6-101′ of the mobile device 6-30 soliciting, based at least in part on a hypothesis 6-71 (e.g., the computing device 6-10 referencing a hypothesis 6-71, or the mobile device 6-30 receiving a request for soliciting from the computing device 6-10, the request being remotely generated and sent to the mobile device 6-30 based at least in part on a hypothesis 6-71) that links one or more objective occurrences with one or more subjective user states (e.g., a group of users 6-20* ingesting a particular type of medicine such as aspirin, and the subsequent subjective physical states, such as pain relief, associated with the group of users 6-20*) and in response at least in part to an incidence of at least one objective occurrence (e.g., ingestion of a medicine by a user 6-20*), subjective user state data 6-60 including data indicating incidence of at least one subjective user state 6-60a (e.g., pain relief by user 6-20*) associated with a user 6-20*.

Note that the solicitation of the subjective user state data 6-60, as described above, may or may not be in reference to solicitation of particular data that indicates occurrence of a particular or particular type of subjective user state. That is, in some embodiments, the solicitation of the subjective user state data 6-60 may be in reference to solicitation for subjective user state data 6-60 including data indicating incidence of any subjective user state with respect to, for example, a particular point in time or time interval. While in other embodiments, the solicitation of the subjective user state data 6-60 may involve solicitation for subjective user state data including solicitation of particular data indicating occurrence of a particular or particular type of subjective user state.

The term “soliciting” as described above may be in reference to direct or indirect solicitation of (e.g., requesting to be provided with, requesting to access, gathering of, or other methods of being provided with, or being allowed access) subjective user state data 6-60 from one or more sources. The sources for the subjective user state data 6-60 may be a user 6-20*, a mobile device 6-30, or one or more network servers (not depicted), which may have already been provided with such subjective user state data 6-60. For example, if the computing device 6-10 is a server, then the computing device 6-10 may indirectly solicit the objective occurrence data 6-70* from a user 6-20a by transmitting the solicitation (e.g., a request or inquiry) to the mobile device 6-30, which may then actually solicit the subjective user state data 6-60 from the user 6-20a. Alternatively, such subjective user state data 6-60 may have already been provided to the mobile device 6-30, in which case the mobile device 6-30 merely provides for or allows access to such data.

In still other alternative implementations, such subjective user state data 6-60 may have been previously stored in a network server (not depicted), and such a network server may be solicited for the subjective user state data 6-60. In yet other implementations in which the computing device 6-10 is a standalone device, such as a handheld device to be used directly by a user 6-20b, the computing device 6-10 may directly solicit the subjective user state data 6-60 from the user 6-20b.

Operational flow 6-300 may further include a subjective user state data acquisition operation 6-304 for acquiring the subjective user state data including the data indicating incidence of at least one subjective user state associated with the user. For instance, the subjective user state data acquisition module 6-102 of the computing device 6-10 or the subjective user state data acquisition module 6-102′ of the mobile device 6-30 acquiring (e.g., receiving by the computing device 6-10 or by the mobile device 6-30 from a user 6-20*) the subjective user state data 6-60.

In various implementations, the subjective user state data solicitation operation 6-302 of FIG. 6-3 may include one or more additional operations as illustrated in FIGS. 6-4a, 6-4b, 6-4c, 6-4d, 6-4e, 6-4f, and 6-4g. For example, in some implementations the subjective user state data solicitation operation 6-302 may include a requesting operation 6-402 for requesting for the data indicating incidence of at least one subjective user state associated with the user as depicted in FIG. 6-4a. For instance, the requesting module 6-202* of the computing device 6-10 or the mobile device 6-30 requesting (e.g., transmitting or indicating a request by the computing device 6-10 or by the mobile device 6-30) for the data indicating incidence of at least one subjective user state 6-60a associated with the user 6-20*.

In various implementations, the requesting operation 6-402 may further include one or more additional operations. For example, in some implementations, the requesting operation 6-402 may include an operation 6-404 for requesting for the data indicating incidence of at least one subjective user state associated with the user via a user interface as depicted in FIG. 6-4a. For example, the user interface requesting module 6-204* of the computing device 6-10 (e.g., when the computing device 6-10 is a standalone device) or the mobile device 6-30 requesting for the data indicating incidence of at least one subjective user state 6-60a associated with the user 6-20* via a user interface 6-122* (e.g. an audio system including one or more speakers or a display system including a display monitor or a touchscreen).

Operation 6-404, in turn, may further include an operation 6-406 for requesting for the data indicating incidence of at least one subjective user state associated with the user from the user as depicted in FIG. 6-4a. For instance, the user interface requesting module 6-204* of the computing device 6-10 or the mobile device 6-30 requesting for the data indicating incidence of at least one subjective user state 6-60a associated with the user 6-20* from the user 6-20*.

In some implementations, operation 6-406 may include an operation 6-408 for indicating the request for the data indicating incidence of at least one subjective user state associated with the user through at least a display system as depicted in FIG. 6-4a. For instance, the request indication module 6-205* of the computing device 6-10 or the mobile device 6-30 indicating the request for the data indicating incidence of at least one subjective user state 6-60a associated with the user 6-20* (e.g., asking the user 6-20*, “how did you feel this morning?”) through at least a display system (e.g., a display system including a display monitor or a touchscreen).

In some implementations, operation 6-406 may include an operation 6-410 for indicating the request for the data indicating incidence of at least one subjective user state associated with the user through at least an audio system as depicted in FIG. 6-4a. For instance, the request indication module 6-205* of the computing device 6-10 or the mobile device 6-30 indicating the request for the data indicating incidence of at least one subjective user state 6-60a associated with the user 6-20* (e.g., asking the user 6-20* “did your pain go away this morning?”) through at least an audio system (e.g., an audio system including at least one audio speaker).

In various implementations, the reception operation 6-402 may include an operation 6-412 for requesting for the data indicating incidence of at least one subjective user state associated with the user via network interface as depicted in FIG. 6-4a. For instance, the network interface requesting module 6-206 of the computing device 6-10 (e.g., when the computing device 6-10 is a server) requesting for the data indicating incidence of at least one subjective user state 6-60a associated with the user 6-20a via network interface 6-120 (e.g., NIC).

In some implementations, operation 6-412 may include an operation 6-414 for transmitting a request to be provided with the data indicating incidence of at least one subjective user state associated with the user as depicted in FIG. 6-4a. For instance, the request transmission module 6-207 of the computing device 6-10 (e.g., when the computing device 6-10 is a server) transmitting a request to be provided with the data indicating incidence of at least one subjective user state 6-60a associated with the user 6-20a.

In some implementations, operation 6-412 may include an operation 6-416 for transmitting a request to have access to the data indicating incidence of at least one subjective user state associated with the user as depicted in FIG. 6-4a. For instance, the request access module 6-208 of the computing device 6-10 transmitting a request (e.g., transmitting a request to the mobile device 6-30, to one or more third parties, or to one or more network servers) to have access to the data indicating incidence of at least one subjective user state 6-60a associated with the user 6-20a.

In some implementations, operation 6-412 may include an operation 6-418 for configuring a remote device to provide the data indicating incidence of at least one subjective user state associated with the user as depicted in FIG. 6-4a. For instance, the configuration module 6-209 configuring a remote device (e.g., a remote network server, the mobile device 6-30, or some other network device) to provide the data indicating incidence of at least one subjective user state 6-60a associated with the user 6-20a.

In some implementations, operation 6-412 may include an operation 6-420 for directing or instructing a remote device to provide the data indicating incidence of at least one subjective user state associated with the user as depicted in FIG. 6-4a. For instance, the directing/instructing module 6-210 directing or instructing a remote device (e.g., transmitting directions or instructions to the remote device such as a remote network server or the mobile device 6-30) to provide the data indicating incidence of at least one subjective user state 6-60a associated with the user 6-20a.

In various implementations, the reception operation 6-402 may include an operation 6-422 for providing a motivation for requesting for the data indicating incidence of at least one subjective user state associated with the user as depicted in FIG. 6-4b. For instance, the motivation provision module 6-212* of the computing device 6-10 or the mobile device 6-30 providing a motivation for requesting for the data indicating incidence of at least one subjective user state 6-60a associated with the user 6-20*. For example, asking and indicating to the user 6-20* “Are you happy? I think it might be the weather.”

In some implementations, operation 6-422 may further include an operation 6-424 for providing a motivation for requesting for the data indicating incidence of at least one subjective user state associated with the user, the motivation to be provided relating to the link between the one or more objective occurrences with the one or more subjective user states as indicated by the hypothesis as depicted in FIG. 6-4b. For instance, the motivation provision module 6-212* of the computing device 6-10 or the mobile device 6-30 providing a motivation for requesting for the data indicating incidence of at least one subjective user state 6-60a associated with the user 6-20*, the motivation to be provided relating to the link between the one or more objective occurrences (e.g., weather conditions) with the one or more subjective user states (e.g., subjective mental state such as happiness or depression) as indicated by the hypothesis 6-71.

In some implementations, the solicitation operation 6-302 of FIG. 6-3 may include an operation 6-426 for soliciting from the user the data indicating incidence of at least one subjective user state associated with the user as depicted in FIG. 6-4b. For instance, the subjective user state data solicitation module 6-101* of the computing device 6-10 or the mobile device 6-30 soliciting from the user 6-20* the data indicating incidence of at least one subjective user state 6-60a associated with the user 6-20*.

Operation 6-426, in turn, may include one or more additional operations in various implementations. For example, in some implementations, operation 6-426 may include an operation 6-428 for requesting the user to select a subjective user state from a plurality of indicated alternative subjective user states as depicted in FIG. 6-4b. For instance, the selection request module 6-214* of the computing device 6-10 or the mobile device 6-30 requesting the user 6-20* to select a subjective user state from a plurality of indicated alternative subjective user states (e.g., asking the user 6-20* through a user interface 6-122* to select from alternate choices of “happy,” “sad,” “in pain,” and “upset stomach”).

In some implementations, operation 6-428 may further include an operation 6-430 for requesting the user to select a subjective user state from a plurality of indicated alternative contrasting subjective user states as depicted in FIG. 6-4b. For instance, the selection request module 6-214* of the computing device 6-10 or the mobile device 6-30 requesting the user 6-20* to select a subjective user state from a plurality of indicated alternative contrasting subjective user states (e.g., asking the user 6-20* through a user interface 6-122* to select from alternative choices of “very happy,” “moderately happy,” “slightly sad,” or “very sad,”).

In some implementations, operation 6-426 may include an operation 6-432 for requesting the user to confirm incidence of at least one subjective user state as depicted in FIG. 6-4b. For instance, the confirmation request module 6-216* of the computing device 6-10 or the mobile device 6-30 requesting the user 6-20* to confirm incidence of at least one subjective user state (e.g., asking the user 6-20* through the user interface 6-122* whether the user 6-20* feels “well”).

In some implementations, operation 6-426 may include an operation 6-434 for requesting the user to provide an indication of occurrence of at least one subjective user state with respect to the incidence of the at least one objective occurrence as depicted in FIG. 6-4b. For instance, the requesting module 6-202* of the computing device 6-10 or the mobile device 6-30 requesting the user 6-20* to provide an indication of occurrence of at least one subjective user state with respect to the incidence of the at least one objective occurrence (e.g., asking the user 6-20* via a user interface 6-122* how the user 6-20* felt after jogging for thirty minutes).

In some implementations, operation 6-426 may include an operation 6-436 for requesting the user to provide an indication of a time or temporal element associated with the incidence of at least one subjective user state associated with the user as depicted in FIG. 6-4c. For instance, the time/temporal element request module 6-218* of the computing device 6-10 or the mobile device 6-30 requesting the user 6-20* to provide an indication of a time or temporal element associated with the incidence of at least one subjective user state associated with the user 6-20* (e.g., asking the user 6-20* via a user interface 6-122 whether the user 6-20* felt tired after lunch?).

In various implementations, operation 6-436 may include one or more additional operations. For example, in some implementations, operation 6-436 may include an operation 6-438 for requesting the user to provide an indication of a point in time associated with the incidence of at least one subjective user state associated with the user as depicted in FIG. 6-4c. For instance, the time/temporal element request module 6-218* of the computing device 6-10 or the mobile device 6-30 requesting the user 6-20* to provide an indication of a point in time (e.g., 8 PM) associated with the incidence of at least one subjective user state (e.g., sleepiness) associated with the user 6-20*.

In some implementations, operation 6-436 may include an operation 6-440 for requesting the user to provide an indication of a time interval associated with the incidence of at least one subjective user state associated with the user as depicted in FIG. 6-4c. For instance, the time/temporal element request module 6-218* of the computing device 6-10 or the mobile device 6-30 requesting the user 6-20* to provide an indication of a time interval (e.g., 7 AM to noon) associated with the incidence of at least one subjective user state (e.g., headache) associated with the user 6-20*.

In some implementations, operation 6-436 may include an operation 6-442 for requesting the user to provide an indication of a temporal relationship between the incidence of the at least one subjective user state associated with the user and the incidence of the at least one objective occurrence as depicted in FIG. 6-4c. For instance, the time/temporal element request module 6-218* of the computing device 6-10 or the mobile device 6-30 requesting the user 6-20* to provide an indication of a temporal relationship between the incidence of the at least one subjective user state associated with the user 6-20* and the incidence of the at least one objective occurrence (e.g., asking the user 6-20* to indicate whether the upset stomach occurred before, after, or at least partly concurrently with eating a hot fudge sundae).

In some implementations, the solicitation operation 6-302 of FIG. 6-3 may include an operation 6-444 for soliciting data indicating incidence of at least one subjective mental state associated with the user as depicted in FIG. 6-4c. For instance, the subjective user state data solicitation module 6-101* of the computing device 6-10 or the mobile device 6-30 soliciting data indicating incidence of at least one subjective mental state (e.g., happiness, sadness, anger, alertness or lack of alertness, fatigue, and so forth) associated with the user 6-20*.

In some implementations, the solicitation operation 6-302 may include an operation 6-446 for soliciting data indicating incidence of at least one subjective physical state associated with the user as depicted in FIG. 6-4c. For instance, the subjective user state data solicitation module 6-101* of the computing device 6-10 or the mobile device 6-30 soliciting data indicating incidence of at least one subjective physical state (e.g., upset stomach, soreness, lack of pain, blurriness of vision, sense of smell, and so forth) associated with the user 6-20*.

In some implementations, the solicitation operation 6-302 may include an operation 6-448 for soliciting data indicating incidence of at least one subjective overall state associated with the user as depicted in FIG. 6-4c. For instance, the subjective user state data solicitation module 6-101* of the computing device 6-10 or the mobile device 6-30 soliciting data indicating incidence of at least one subjective overall state (e.g., good, bad, overall wellness, exhaustion, and so forth) associated with the user 6-20*.

In some implementations, the solicitation operation 6-302 may include an operation 6-450 for soliciting data indicating incidence of at least one subjective user state that occurred during a specified point in time as depicted in FIG. 6-4d. For instance, the subjective user state data solicitation module 6-101* of the computing device 6-10 or the mobile device 6-30 soliciting data indicating incidence of at least one subjective user state associated with the user 6-20* that occurred during a specified point in time (e.g., asking the user 6-20* how the user 6-20* felt at 8 PM).

In some implementations, the solicitation operation 6-302 may include an operation 6-452 for soliciting data indicating incidence of at least one subjective user state that occurred during a specified time interval as depicted in FIG. 6-4d. For instance, the subjective user state data solicitation module 6-101* of the computing device 6-10 or the mobile device 6-30 soliciting data indicating incidence of at least one subjective user state associated with the user 6-20* that occurred during a specified time interval (e.g., asking the user 6-20* how the user 6-20* felt between 8 PM and 10 PM).

In various embodiments, the solicitation operation 6-302 may include operations that may be particular to the computing device 6-10, which may be a standalone device or a network server. For example, in some implementations, the solicitation operation 6-302 may include an operation 6-453 for soliciting the data indicating incidence of at least one subjective user state based, at least in part, on referencing the hypothesis as depicted in FIG. 6-4d. In certain implementations, such an operation may be performed by the computing device 6-10 rather than by the mobile device 6-30. For these implementations, the subjective user state data solicitation module 6-101 of the computing device 6-10 may solicit the data indicating incidence of at least one subjective user state 6-60a based, at least in part, on the hypothesis referencing module 6-220 referencing the hypothesis 6-71, which in some cases may be stored in memory 6-140.

In various implementations, operation 6-453 may further include one or more additional operations. For example, in some implementations, operation 6-453 may include an operation 6-454 for soliciting the data indicating incidence of at least one subjective user state associated with the user based, at least in part, on referencing a hypothesis that identifies one or more temporal relationships between the one or more objective occurrences and the one or more subjective user states as depicted in FIG. 6-4d. For instance, the subjective user state data solicitation module 6-101 of the computing device 6-10 soliciting the data indicating incidence of at least one subjective user state 6-60a associated with the user 6-20* based, at least in part, on referencing a hypothesis 6-71 that identifies at least one or more temporal relationships between the one or more objective occurrences and the one or more subjective user states (e.g., an hypothesis 6-71 that indicates that a user 6-20* or a group of users 6-20* may tend to have stomach aches after eating hot fudge sundaes).

In some implementations, operation 6-454 may include an operation 6-456 for soliciting the data indicating incidence of at least one subjective user state associated with the user based, at least in part, on referencing a hypothesis that identifies one or more time sequential relationships between the at least one objective occurrences and the one or more subjective user states as depicted in FIG. 6-4d. For instance, the subjective user state data solicitation module 6-101 of the computing device 6-10 soliciting the data indicating incidence of at least one subjective user state 6-60a associated with the user 6-20* based, at least in part, on referencing a hypothesis 6-71 that identifies at least one or more time sequential relationships between the at least one objective occurrences and the one or more subjective user states (e.g., hypothesis 6-71 indicating that a stomach ache will tend to occur two hours after eating a hot fudge sundae).

In some implementations, operation 6-453 may include an operation 6-458 for soliciting the data indicating incidence of at least one subjective user state associated with the user based, at least in part, on referencing a hypothesis that identifies a relationship between at least an ingestion of a medicine and the one or more subjective user states as depicted in FIG. 6-4d. For instance, the subjective user state data solicitation module 6-101 of the computing device 6-10 soliciting (e.g., via the network interface 6-120 or via the user interface 6-122) the data indicating incidence of at least one subjective user state 6-60a associated with the user 6-20* based, at least in part, on referencing a hypothesis 6-71 that identifies a relationship between at least an ingestion of a medicine (e.g., aspirin) and the one or more subjective user states (e.g., easing of pain).

In some implementations, operation 6-453 may include an operation 6-460 for soliciting the data indicating incidence of at least one subjective user state associated with the user based, at least in part, on referencing a hypothesis that identifies a relationship between at least an ingestion of a food item and the one or more subjective user states as depicted in FIG. 6-4d. For instance, the subjective user state data solicitation module 6-101 of the computing device 6-10 soliciting (e.g., via the network interface 6-120 or via the user interface 6-122) the data indicating incidence of at least one subjective user state 6-60a associated with the user 6-20* based, at least in part, on referencing a hypothesis 6-71 that identifies a relationship between at least an ingestion of a food item and the one or more subjective user states (e.g., a user 6-20* tends to be happy after eating a hot fudge sundae).

In some implementations, operation 6-453 may include an operation 6-462 for soliciting the data indicating incidence of at least one subjective user state associated with the user based, at least in part, on referencing a hypothesis that identifies a relationship between at least an ingestion of a nutraceutical and the one or more subjective user states as depicted in FIG. 6-4e. For instance, the subjective user state data solicitation module 6-101 of the computing device 6-10 soliciting (e.g., via the network interface 6-120 or via the user interface 6-122) the data indicating incidence of at least one subjective user state 6-60a associated with the user 6-20* based, at least in part, on referencing a hypothesis 6-71 that identifies a relationship between at least an ingestion of a nutraceutical and the one or more subjective user states.

In some implementations, operation 6-453 may include an operation 6-463 for soliciting the data indicating incidence of at least one subjective user state associated with the user based, at least in part, on referencing a hypothesis that identifies a relationship between execution of one or more exercise routines and the one or more subjective user states as depicted in FIG. 6-4e. For instance, the subjective user state data solicitation module 6-101 of the computing device 6-10 soliciting (e.g., via the network interface 6-120 or via the user interface 6-122) the data indicating incidence of at least one subjective user state 6-60a associated with the user 6-20* based, at least in part, on referencing a hypothesis 6-71 that identifies a relationship between execution of one or more exercise routines (e.g., jogging) and the one or more subjective user states (e.g., sore knees). For example, the hypothesis 6-71 may indicate that sore knees may result after jogging.

In some implementations, operation 6-453 may include an operation 6-464 for soliciting the data indicating incidence of at least one subjective user state associated with the user based, at least in part, on referencing a hypothesis that identifies a relationship between execution of one or more social activities and the one or more subjective user states as depicted in FIG. 6-4e. For instance, the subjective user state data solicitation module 6-101 of the computing device 6-10 soliciting (e.g., via the network interface 6-120 or via the user interface 6-122) the data indicating incidence of at least one subjective user state 6-60a associated with the user 6-20* based, at least in part, on referencing a hypothesis 6-71 that identifies a relationship between execution of one or more social activities (e.g., meeting in-laws) and the one or more subjective user states (e.g., anxiety). For example, the hypothesis 6-71 may indicate that feelings of anxiety may occur when meeting the in-laws.

In some implementations, operation 6-453 may include an operation 6-465 for soliciting the data indicating incidence of at least one subjective user state associated with the user based, at least in part, on referencing a hypothesis that identifies a relationship between one or more activities executed by a third party and the one or more subjective user states as depicted in FIG. 6-4e. For instance, the subjective user state data solicitation module 6-101 of the computing device 6-10 soliciting (e.g., via the network interface 6-120 or via the user interface 6-122) the data indicating incidence of at least one subjective user state 6-60a associated with the user 6-20* based, at least in part, on referencing a hypothesis 6-71 that identifies a relationship between one or more activities executed by a third party (e.g., boss leaving town) and the one or more subjective user states (e.g., relaxation). For example, the hypothesis 6-71 may indicate that a user 6-20* may be relaxed or more relaxed when the boss leaves town.

In some implementations, operation 6-453 may include an operation 6-466 for soliciting the data indicating incidence of at least one subjective user state associated with the user based, at least in part, on referencing a hypothesis that identifies a relationship between one or more physical characteristics of the user and the one or more subjective user states as depicted in FIG. 6-4e. For instance, the subjective user state data solicitation module 6-101 of the computing device 6-10 soliciting (e.g., via the network interface 6-120 or via the user interface 6-122) the data indicating incidence of at least one subjective user state 6-60a associated with the user 6-20* based, at least in part, on referencing a hypothesis 6-71 that identifies a relationship between one or more physical characteristics (e.g., high blood pressure) of the user 6-20* and the one or more subjective user states (e.g., fatigue). For example, the hypothesis 6-71 may indicate that a user 6-20* may be fatigued or more fatigued whenever the blood pressure of the user 6-20* is high.

In some implementations, operation 6-453 may include an operation 6-467 for soliciting the data indicating incidence of at least one subjective user state associated with the user based, at least in part, on referencing a hypothesis that identifies a relationship between a resting, a learning, or a recreation activity performed by the user and the one or more subjective user states as depicted in FIG. 6-4e. For instance, the subjective user state data solicitation module 6-101 of the computing device 6-10 soliciting (e.g., via the network interface 6-120 or via the user interface 6-122) the data indicating incidence of at least one subjective user state 6-60a associated with the user 6-20* based, at least in part, on referencing a hypothesis 6-71 that identifies a relationship between a resting (e.g., sleeping), a learning (e.g., reading a book or attending a lecture or class), or a recreation (e.g., playing golf) activity performed by the user 6-20* and the one or more subjective user states.

In some implementations, operation 6-453 may include an operation 6-468 for soliciting the data indicating incidence of at least one subjective user state associated with the user based, at least in part, on referencing a hypothesis that identifies a relationship between one or more external activities and the one or more subjective user states as depicted in FIG. 6-4f. For instance, the subjective user state data solicitation module 6-101 of the computing device 6-10 soliciting (e.g., via the network interface 6-120 or via the user interface 6-122) the data indicating incidence of at least one subjective user state 6-60a associated with the user 6-20* based, at least in part, on referencing a hypothesis 6-71 that identifies a relationship between one or more external activities (e.g., overcast weather) and the one or more subjective user states (e.g., depression).

In some implementations, operation 6-453 may include an operation 6-469 for soliciting the data indicating incidence of at least one subjective user state associated with the user based, at least in part, on referencing a hypothesis that identifies a relationship between one or more locations of the user and the one or more subjective user states as depicted in FIG. 6-4f. For instance, the subjective user state data solicitation module 6-101 of the computing device 6-10 soliciting (e.g., via the network interface 6-120 or via the user interface 6-122) the data indicating incidence of at least one subjective user state 6-60a associated with the user 6-20* based, at least in part, on referencing a hypothesis 6-71 that identifies a relationship between one or more locations (e.g., New York City) of the user 6-20* and the one or more subjective user states (e.g., anxiety).

In some implementations, operation 6-453 may include an operation 6-470 for soliciting the data indicating incidence of at least one subjective user state associated with the user based, at least in part, on referencing a hypothesis that links the at least one objective occurrence with one or more historical subjective user states associated with the user as depicted in FIG. 6-4f. For instance, the subjective user state data solicitation module 6-101 of the computing device 6-10 soliciting (e.g., via the network interface 6-120 or via the user interface 6-122) the data indicating incidence of at least one subjective user state 6-60a associated with the user 6-20* based, at least in part, on referencing a hypothesis 6-71 that links the at least one objective occurrence (e.g., user 6-20* exercising) with one or more historical subjective user states (e.g., feeling energetic) associated with the user 6-20*.

In some implementations, operation 6-453 may include an operation 6-471 for soliciting the data indicating incidence of the at least one subjective user state associated with the user based, at least in part, on referencing a hypothesis that links the at least one objective occurrence with one or more historical subjective user states associated with a plurality of users as depicted in FIG. 6-4f. For instance, the subjective user state data solicitation module 6-101 of the computing device 6-10 soliciting (e.g., via the network interface 6-120 or via the user interface 6-122) the data indicating incidence of at least one subjective user state 6-60a associated with the user 6-20* based, at least in part, on referencing a hypothesis 6-71 that links the at least one objective occurrence (e.g., stock market performance) with one or more historical subjective user states (e.g., depression) associated with a plurality of users 6-20*.

In some implementations, operation 6-453 may include an operation 6-472 for soliciting the data indicating incidence of at least one subjective user state associated with the user based, at least in part, on referencing a hypothesis that links the at least one objective occurrence with one or more historical subjective user states associated with at least a subset of a general population as depicted in FIG. 6-4f. For instance, the subjective user state data solicitation module 6-101 of the computing device 6-10 soliciting (e.g., via the network interface 6-120 or via the user interface 6-122) the data indicating incidence of at least one subjective user state 6-60a associated with the user 6-20* based, at least in part, on referencing a hypothesis 6-71 that links the at least one objective occurrence with one or more historical subjective user states associated with at least a subset of a general population.

In various implementations, the solicitation operation 6-302 may include one or more operations that may be performed by the mobile device 6-30 rather than by the computing device 6-10. For example, in some implementations, the solicitation operation 6-302 may include an operation 6-477 for soliciting the data indicating incidence of at least one subjective user state associated with the user in response to a reception of a request to solicit the data indicating incidence of at least one subjective user state associated with the user, the request to solicit being remotely generated based, at least in part, on the hypothesis as depicted in FIG. 6-4g. For instance, the subjective user state data solicitation module 6-101′ of the mobile device 6-30 soliciting the data indicating incidence of at least one subjective user state 6-60a associated with the user 6-20a from the user 6-20a in response to the “request to solicit” reception module 6-270 of the mobile device 6-30 receiving (e.g., receiving from a network server such as the computing device 6-10 via a wireless and/or wired network 6-40) a request to solicit the data indicating incidence of at least one subjective user state 6-60a associated with the user 6-20a, the request to solicit being remotely generated (e.g., remotely generated at the computing device 6-10) based, at least in part, on the hypothesis 6-71.

In some implementations, operation 6-477 may further include an operation 6-478 for soliciting the data indicating incidence of at least one subjective user state associated with the user in response to a reception of a request to solicit the data indicating incidence of at least one subjective user state associated with the user, the request to solicit being remotely generated based, at least in part, on the hypothesis and in response to the incidence of the at least one objective occurrence as depicted in FIG. 6-4g. For instance, the subjective user state data solicitation module 6-101′ of the mobile device 6-30 soliciting the data indicating incidence of at least one subjective user state 6-60a associated with the user 6-20a from the user 6-20a in response to the “request to solicit” reception module 6-270 of the mobile device 6-30 receiving (e.g., receiving from a network server such as the computing device 6-10 via a wireless and/or wired network 6-40) a request to solicit the data indicating incidence of the at least one subjective user state 6-60a associated with the user 6-20a, the request to solicit being remotely generated (e.g., remotely generated by a network server such as the computing device) based, at least in part, on the hypothesis 6-71 and in response to the incidence of the at least one objective occurrence (e.g., the incidence of the at least one objective occurrence being reported to the computing device 6-10).

In some implementations, operation 6-477 may further include an operation 6-479 for receiving the request to solicit the data indicating incidence of at least one subjective user state associated with the user via at least one of a wireless network or a wired network as depicted in FIG. 6-4g. For instance, the “request to solicit” reception module 6-270 of the mobile device 6-30 receiving the request to solicit the data indicating incidence of at least one subjective user state 6-60a associated with the user 6-20a via at least one of a wireless network or a wired network 6-40.

Operation 6-479, in turn, may further include an operation 6-480 for receiving the request to solicit the data indicating incidence of at least one subjective user state associated with the user from a network server as depicted in FIG. 6-4g. For instance, the “request to solicit” reception module 6-270 of the mobile device 6-30 receiving the request to solicit the data indicating incidence of at least one subjective user state 6-60a associated with the user 6-20a from a network server (e.g., computing device 6-10).

In various implementations, the solicitation operation 6-302 of FIG. 6-3 may include an operation 6-482 for soliciting data indicating incidence of a particular or a particular type of subjective user state associated with the user based, at least in part, on the hypothesis as depicted in FIG. 6-4g. For instance, the subjective user state data solicitation module 6-101* of the computing device 6-10 or the mobile device 6-30 soliciting data indicating incidence of a particular or a particular type of subjective user state associated with the user 6-20* based, at least in part, on the hypothesis 6-71. For example, asking for the subjective mental state a user 6-20* (e.g., asking the user 6-20* whether the user 6-20* is happy or sad?).

In some implementations, the solicitation operation 6-302 may include an operation 6-484 for soliciting data indicating incidence of at least one subjective user state associated with the user at a particular point in time as depicted in FIG. 6-4g. For instance, the subjective user state data solicitation module 6-101* of the computing device 6-10 or the mobile device 6-30 soliciting data indicating incidence of at least one subjective user state associated with the user 6-20* at or for a particular point in time (e.g., 1 PM). For example, asking a user 6-20* how the user 6-20* felt at 1 PM.

In some implementations, the solicitation operation 6-302 may include an operation 6-486 for soliciting data indicating incidence of at least one subjective user state associated with the user during a particular time interval as depicted in FIG. 6-4g. For instance, the subjective user state data solicitation module 6-101* of the computing device 6-10 or the mobile device 6-30 soliciting data indicating incidence of at least one subjective user state 6-60a associated with the user 6-20* during a particular time interval (e.g., 1 PM to 3 PM). For example, asking a user 6-20* how the user 6-20* felt between 1 PM and 3 PM.

Referring back to FIG. 6-3, the subjective user state data acquisition operation 6-304 may include one or more additional operations in various alternative implementations. For example, in some implementations, the subjective user state data acquisition operation 6-304 may include a reception operation 6-502 for receiving the subjective user state data including the data indicating incidence of at least one subjective user state associated with the user as depicted in FIG. 6-5a. For instance the subjective user state data reception module 6-224* of the computing device 6-10 or the mobile device 6-30 receiving the subjective user state data 6-60 including the data indicating incidence of at least one subjective user state 6-60a associated with the user 6-20*.

In various implementations, the reception operation 6-502 may include one or more additional operations. For example, in some implementations, the reception operation 6-502 may include an operation 6-504 for receiving the subjective user state data including the data indicating incidence of at least one subjective user state associated with the user via a user interface as depicted in FIG. 6-5a. For instance, the user interface reception module 6-226* of the computing device 6-10 or the mobile device 6-30 receiving the subjective user state data 6-60 including the data indicating incidence of at least one subjective user state 6-60a associated with the user 6-20* via a user interface 6-122* (e.g., an audio system or a display system).

The reception operation 6-502, in some implementations, may include operations that may be particular to the computing device 6-10 (e.g., when the computing device is a network server) and may not be executed by the mobile device 6-30. For example, in some implementations, the reception operation 6-502 may include an operation 6-506 for receiving the subjective user state data including the data indicating incidence of at least one subjective user state associated with the user from at least one of a wireless network or a wired network as depicted in FIG. 6-5a. For instance, the network interface reception module 6-227 of the computing device 6-10 receiving the subjective user state data 6-60 including the data indicating incidence of at least one subjective user state 6-60a associated with the user 6-20a from at least one of a wireless network or a wired network 6-40.

In some implementations, operation 6-506 may further include an operation 6-508 for receiving the subjective user state data including data indicating incidence of at least one subjective user state associated with the user via one or more electronic messages generated by the user as depicted in FIG. 6-5a. For instance, the network interface reception module 6-227 of the computing device 6-10 receiving the subjective user state data 6-60 including the data indicating incidence of at least one subjective user state 6-60a associated with the user 6-20a via one or more electronic messages generated by the user 6-20a.

In some implementations, operation 6-506 may include an operation 6-510 for receiving the subjective user state data including data indicating incidence of at least one subjective user state associated with the user via one or more blog entries generated by the user as depicted in FIG. 6-5a. For instance, the network interface reception module 6-227 of the computing device 6-10 receiving the subjective user state data 6-60 including the data indicating incidence of at least one subjective user state 6-60a associated with the user 6-20a via one or more blog entries (e.g., microblog entries) generated by the user 6-20a.

In some implementations, operation 6-506 may include an operation 6-512 for receiving the subjective user state data including data indicating incidence of at least one subjective user state associated with the user via one or more status reports generated by the user as depicted in FIG. 6-5a. For instance, the network interface reception module 6-227 of the computing device 6-10 receiving the subjective user state data 6-60 including the data indicating incidence of at least one subjective user state 6-60a associated with the user 6-20a via one or more status reports (e.g., social networking status reports) generated by the user 6-20a.

In certain implementations, the reception operation 6-502 may include an operation 6-514 for receiving a selection made by the user, the selection being a selection of a subjective user state from a plurality of indicated alternative subjective user states as depicted in FIG. 6-5a. For instance, the subjective user state data reception module 6-224* of the computing device 6-10 or the mobile device 6-30 receiving a selection made by the user 6-20*, the selection being a selection of a subjective user state (e.g., happy) from a plurality of indicated alternative subjective user states (e.g., happy, sad, in pain, alert, and so forth) that may be indicated via, for example, a user interface 6-122*.

In some implementations, the subjective user state data acquisition operation 6-304 of FIG. 6-3 may include an operation 6-516 for acquiring data indicating at least one subjective mental state associated with the user as depicted in FIG. 6-5b. For instance, the subjective user state data acquisition module 6-102* of the computing device 6-10 or the mobile device 6-30 acquiring (e.g., receiving or obtaining through a network interface 6-120* or through a user interface 6-122*) data indicating at least one subjective mental state (e.g., level of happiness, level of sadness, alertness, level of fatigue, level of pain, and so forth) associated with the user 6-20*.

In some implementations, the subjective user state data acquisition operation 6-304 may include an operation 6-518 for acquiring data indicating at least one subjective physical state associated with the user as depicted in FIG. 6-5b. For instance, the subjective user state data acquisition module 6-102* of the computing device 6-10 or the mobile device 6-30 acquiring (e.g., receiving or obtaining through a network interface 6-120* or through a user interface 6-122*) data indicating at least one subjective physical state (e.g., vision acuity, hearing acuity, level of physical pain, and so forth) associated with the user 6-20*.

In some implementations, the subjective user state data acquisition operation 6-304 may include an operation 6-520 for acquiring data indicating at least one subjective overall state associated with the user as depicted in FIG. 6-5b. For instance, the subjective user state data acquisition module 6-102* of the computing device 6-10 or the mobile device 6-30 acquiring (e.g., receiving or obtaining through a network interface 6-120* or through a user interface 6-122*) data indicating at least one subjective overall state (e.g., overall wellness, good, bad, and so forth) associated with the user 6-20*.

In some implementations, the subjective user state data acquisition operation 6-304 may include an operation 6-522 for acquiring a time stamp associated with the at least one subjective user state as depicted in FIG. 6-5b. For instance, the time stamp acquisition module 6-230* of the computing device 6-10 or the mobile device 6-30 acquiring (e.g., receiving through a network interface 6-120 or a user interface 6-122, or by self-generating) at least one time stamp associated with the at least one subjective user state.

In some implementations, the subjective user state data acquisition operation 6-304 may include an operation 6-524 for acquiring an indication of a time interval associated with the at least one subjective user state as depicted in FIG. 6-5b. For instance, the time interval acquisition module 6-241* of the computing device 6-10 or the mobile device 6-30 acquiring (e.g., receiving through a network interface 6-120 or a user interface 6-122, or by self-generating) at least an indication of a time interval associated with the at least one subjective user state.

In some implementations, the subjective user state data acquisition operation 6-304 may include an operation 6-526 for acquiring an indication of a temporal relationship between the at least one subjective user state and the at least one objective occurrence as depicted in FIG. 6-5b. For instance, the temporal relationship acquisition module 6-232* of the computing device 6-10 or the mobile device 6-30 acquiring (e.g., receiving through a network interface 6-120 or a user interface 6-122, or by self-generating) at least an indication of a temporal relationship (e.g., before, after, or at least partly concurrently) between the at least one subjective user state (e.g., subjective mental state) and the at least one objective occurrence (e.g., ingestion of medicine).

In some implementations, the subjective user state data acquisition operation 6-304 may include an operation 6-528 for acquiring the data indicating incidence of at least one subjective user state associated with the user at a server as depicted in FIG. 6-5b. For instance, when the computing device 6-10 is a network server and is acquiring the data indicating incidence of at least one subjective user state 6-60a associated with the user 6-20a.

In some implementations, the subjective user state data acquisition operation 6-304 may include an operation 6-530 for acquiring the data indicating incidence of at least one subjective user state associated with the user at a handheld device as depicted in FIG. 6-5b. For instance, when the computing device 6-10 or the mobile device 6-30 is a handheld device (e.g., a cellular telephone, a PDA, and so forth) and is acquiring the data indicating incidence of at least one subjective user state 6-60a associated with the user 6-20*.

In some implementations, the subjective user state data acquisition operation 6-304 may include an operation 6-532 for acquiring the data indicating incidence of at least one subjective user state associated with the user at a peer-to-peer network component device as depicted in FIG. 6-5b. For instance, when the computing device 6-10 or the mobile device 6-30 is a peer-to-peer network component device and is acquiring the data indicating incidence of at least one subjective user state 6-60 associated with the user 6-20*.

In some implementations, the subjective user state data acquisition operation 6-304 may include an operation 6-534 for acquiring the data indicating incidence of at least one subjective user state associated with the user via a Web 2.0 construct as depicted in FIG. 6-5b. For instance, when the computing device 6-10 or the mobile device 6-30 is acquiring the data indicating incidence of at least one subjective user state 6-60a associated with the user 6-20* via a Web 2.0 construct.

Referring to FIG. 6-6 illustrating another operational flow 6-600 in accordance with various embodiments. Operational flow 6-600 includes certain operations that mirror the operations included in operational flow 6-300 of FIG. 6-3. These operations include a subjective user state data solicitation operation 6-602 and a subjective user state data acquisition operation 6-604 that corresponds to and mirror the subjective user state data solicitation operation 6-302 and the subjective user state data acquisition operation 6-304, respectively, of FIG. 6-3.

In addition, operational flow 6-600 includes an objective occurrence data acquisition operation 6-606 for acquiring objective occurrence data including data indicating incidence of the at least one objective occurrence as depicted in FIG. 6-6. For instance, the objective occurrence data acquisition module 6-104* of the computing device 6-10 or the mobile device 6-30 acquiring (e.g., receiving, gathering, or retrieving via network interface 6-120* or via the user interface 6-122*) objective occurrence data 6-70* including data indicating incidence of the at least one objective occurrence.

In various alternative implementations, the objective occurrence data acquisition operation 6-606 may include one or more additional operations. For example, in some implementations, operation 6-606 may include a reception operation 6-702 for receiving the objective occurrence data as depicted in FIG. 6-7a. For instance, the objective occurrence data reception module 6-234* of the computing device 6-10 or the mobile device 6-30 receiving the objective occurrence data 6-70*.

The reception operation 6-702, in turn, may include one or more additional operations in various alternative implementations. For example, in some implementations, the reception operation 6-702 may include an operation 6-704 for receiving the objective occurrence data via a user interface as depicted in FIG. 6-7a. For instance, the user interface data reception module 6-235* of the computing device 6-10 (e.g., when the computing device 6-10 is a standalone device) or the mobile device 6-30 receiving the objective occurrence data 6-70c via a user interface 6-122* (e.g., a keyboard, a mouse, a touchscreen, a microphone, an image capturing device such as a digital camera, and so forth).

In some implementations, the reception operation 6-702 may include an operation 6-706 for receiving the objective occurrence data from at least one of a wireless network or a wired network as depicted in FIG. 6-7a. For instance, the network interface data reception module 6-236* of the computing device 6-10 or the mobile device 6-30 receiving the objective occurrence data 6-70* from at least one of a wireless network or a wired network 6-40. Note that a mobile device 6-30, in some cases, may be provided with the objective occurrence data 6-70a from one or more third party sources 6-50. In such a scenario, the mobile device 6-30 may initially collect the objective occurrence data 6-70a before transmitting the objective occurrence data 6-70a to, for example, the computing device 6-10 (e.g., network server) where such data may be processed during a correlation operation.

In some implementations, the reception operation 6-702 may include an operation 6-708 for receiving the objective occurrence data via one or more blog entries as depicted in FIG. 6-7a. For instance, the network interface data reception module 6-236* of the computing device 6-10 or the mobile device 6-30 receiving the objective occurrence data 6-70a or 6-70c via one or more blog entries (e.g., microblog entries).

In some implementations, the reception operation 6-702 may include an operation 6-710 for receiving the objective occurrence data via one or more status reports as depicted in FIG. 6-7a. For instance, the network interface data reception module 6-236* of the computing device 6-10 or the mobile device 6-30 receiving the objective occurrence data 6-70a or 6-70c via one or more status reports (e.g., social networking status reports).

In some implementations, the reception operation 6-702 may include an operation 6-712 for receiving the objective occurrence data from one or more third party sources as depicted in FIG. 6-7a. For instance, the network interface data reception module 6-236* of the computing device 6-10 or the mobile device 6-30 receiving the objective occurrence data 6-70c from one or more third party sources 6-50.

In some implementations, the reception operation 6-702 may include an operation 6-714 for receiving the objective occurrence data from one or more sensors as depicted in FIG. 6-7a. For instance, the network interface data reception module 6-236* of the computing device 6-10 or the mobile device 6-30 receiving the objective occurrence data 6-70c from one or more sensors 6-35.

In some implementations, the reception operation 6-702 may include an operation 6-716 for receiving the objective occurrence data from the user as depicted in FIG. 6-7a. For instance, the network interface data reception module 6-236 of the computing device 6-10 receiving the objective occurrence data 6-70c from the user 6-20a.

In various implementations, the objective occurrence data acquisition operation 6-606 of FIG. 6-6 may include an operation 6-718 for acquiring a time stamp associated with the incidence of the at least one objective occurrence as depicted in FIG. 6-7a. For instance, the time stamp acquisition module 6-240* of the computing device 6-10 or the mobile device 6-30 acquiring (e.g., by receiving or by self-generating) a time stamp associated with the incidence of the at least one objective occurrence.

In some implementations, the objective occurrence data acquisition operation 6-606 may include an operation 6-720 for acquiring an indication of a time interval associated with the incidence of the at least one objective occurrence as depicted in FIG. 6-7a. For instance, the time interval acquisition module 6-241* of the computing device 6-10 or the mobile device 6-30 acquiring an indication of a time interval associated with the incidence of the at least one objective occurrence.

In some implementations, the objective occurrence data acquisition operation 6-606 may include an operation 6-722 for acquiring data indicating one or more attributes associated with the at least one objective occurrence as depicted in FIG. 6-7a. For instance, the objective occurrence data acquisition module 6-104* of the computing device 6-10 or the mobile device 6-30 acquiring data indicating one or more attributes (e.g., quantity and brand of a medicine) associated with the at least one objective occurrence (e.g., ingestion of the medicine).

In some implementations, the objective occurrence data acquisition operation 6-606 may include an operation 6-724 for acquiring data indicating an ingestion by the user of a medicine as depicted in FIG. 6-7b. For instance, the objective occurrence data acquisition module 6-104* of the computing device 6-10 or the mobile device 6-30 acquiring data indicating an ingestion by the user 6-20* of a medicine (e.g., a dosage of a beta blocker).

In some implementations, the objective occurrence data acquisition operation 6-606 may include an operation 6-726 for acquiring data indicating an ingestion by the user of a food item as depicted in FIG. 6-7b. For instance, the objective occurrence data acquisition module 6-104* of the computing device 6-10 or the mobile device 6-30 acquiring data indicating an ingestion by the user 6-20* of a food item (e.g., orange).

In some implementations, the objective occurrence data acquisition operation 6-606 may include an operation 6-728 for acquiring data indicating an ingestion by the user of a nutraceutical as depicted in FIG. 6-7b. For instance, the objective occurrence data acquisition module 6-104* of the computing device 6-10 or the mobile device 6-30 acquiring data indicating an ingestion by the user 6-20* of a nutraceutical (e.g. broccoli).

In some implementations, the objective occurrence data acquisition operation 6-606 may include an operation 6-730 for acquiring data indicating an exercise routine executed by the user as depicted in FIG. 6-7b. For instance, the objective occurrence data acquisition module 6-104* of the computing device 6-10 or the mobile device 6-30 acquiring data indicating an exercise routine executed (e.g., exercising on an exercise machine such as a treadmill) by the user 6-20*.

In some implementations, the objective occurrence data acquisition operation 6-606 may include an operation 6-732 for acquiring data indicating a social activity executed by the user as depicted in FIG. 6-7b. For instance, the objective occurrence data acquisition module 6-104* of the computing device 6-10 or the mobile device 6-30 acquiring data indicating a social activity (e.g., hiking or skiing with friends, dates, dinners, and so forth) executed by the user 6-20*.

In some implementations, the objective occurrence data acquisition operation 6-606 may include an operation 6-734 for acquiring data indicating an activity performed by a third party as depicted in FIG. 6-7b. For instance, the objective occurrence data acquisition module 6-104* of the computing device 6-10 or the mobile device 6-30 acquiring data indicating an activity performed by a third party (e.g., spouse visiting relatives).

In some implementations, the objective occurrence data acquisition operation 6-606 may include an operation 6-736 for acquiring data indicating a physical characteristic of the user as depicted in FIG. 6-7b. For instance, the objective occurrence data acquisition module 6-104* of the computing device 6-10 or the mobile device 6-30 acquiring data indicating a physical characteristic (e.g., a blood sugar level) of the user 6-20*. Note that a physical characteristic such as a blood sugar level could be determined using a device such as a glucometer and then reported by a user 6-20*, by a third party source 6-50, or by the device (e.g., glucometer) itself.

In some implementations, the objective occurrence data acquisition operation 6-606 may include an operation 6-738 for acquiring data indicating a resting, a learning or a recreational activity by the user as depicted in FIG. 6-7b. For instance, the objective occurrence data acquisition module 6-104* of the computing device 6-10 or the mobile device 6-30 acquiring data indicating a resting (e.g., sleeping), a learning (reading a book or attending a lecture or a class) or a recreational activity (e.g., golfing) by the user 6-20*.

In some implementations, the objective occurrence data acquisition operation 6-606 may include an operation 6-740 for acquiring data indicating occurrence of an external event as depicted in FIG. 6-7b. For instance, the objective occurrence data acquisition module 6-104* of the computing device 6-10 or the mobile device 6-30 acquiring data indicating occurrence of an external event (e.g., 100 degree daytime high).

In some implementations, the objective occurrence data acquisition operation 6-606 may include an operation 6-742 for acquiring data indicating a location of the user as depicted in FIG. 6-7b. For instance, the objective occurrence data acquisition module 6-104* of the computing device 6-10 or the mobile device 6-30 acquiring data indicating a location of the user 6-20*.

Referring now to FIG. 6-8 illustrating still another operational flow 6-800 in accordance with various embodiments. In some embodiments, operational flow 6-800 may be particularly suited to be performed by the computing device 6-10, which as previously indicated, may be a network server or a standalone device. Operational flow 6-800 includes operations that mirror the operations included in the operational flow 6-600 of FIG. 6-6. These operations include, for example, a subjective user state data solicitation operation 6-802, a subjective user state data acquisition operation 6-804, and an objective occurrence data acquisition operation 6-806 that corresponds to and mirror the subjective user state data solicitation operation 6-602, the subjective user state data acquisition operation 6-604, and the objective occurrence data acquisition operation 6-606, respectively, of FIG. 6-6.

In addition, operational flow 6-800 may further include a correlation operation 6-808 for correlating the subjective user state data with the objective occurrence data and a presentation operation 6-810 for presenting one or more results of the correlating of the subjective user state data with the objective occurrence data as depicted in FIG. 6-8. For instance, the correlation module 6-106 of the computing device 6-10 correlating (e.g., linking or determining a relationship) the subjective user state data 6-60 with the objective occurrence data 6-70*. The presentation module 6-108 of the computing device 6-10 may then present (e.g., transmit via a network interface 6-120 or indicate via a user interface 6-122) one or more results of the correlation operation performed by the correlation module 6-106.

In various alternative implementations, the correlation operation 6-808 may include one or more additional operations. For example, in some implementations, the correlation operation 6-808 may include an operation 6-902 for correlating the subjective user state data with the objective occurrence data based, at least in part, on a determination of at least one sequential pattern associated with the at least one subjective user state and the at least one objective occurrence as depicted in FIG. 6-9. For instance, the correlation module 6-106 of the computing device 6-10 correlating the subjective user state data 6-60 with the objective occurrence data 6-70* based, at least in part, on the sequential pattern determination module 6-242 determining at least one sequential pattern associated with the at least one subjective user state indicated by the subjective user state data 6-60 and the at least one objective occurrence indicated by the objective occurrence data 6-70*.

Operation 6-902, in turn, may further include one or more additional operations. For example, in some implementations, operation 6-902 may include an operation 6-904 for correlating the subjective user state data with the objective occurrence data based, at least in part, on referencing historical data as depicted in FIG. 6-9. For instance, the correlation module 6-106 of the computing device 6-10 correlating the subjective user state data 6-60 with the objective occurrence data 6-70* based, at least in part, on the historical data referencing module 6-243 referencing historical data 6-72. Historical data 6-72 may include, for example, previously reported incidences of subjective user states associated with the user 6-20* or with other users 6-20*, previously reported incidences of objective occurrences, historical sequential patterns associated with the user 6-20* or with other users 6-20*, and/or other types of historical data 6-72.

In some implementations, operation 6-904 may include an operation 6-906 for correlating the subjective user state data with the objective occurrence data based, at least in part, on a historical sequential pattern as depicted in FIG. 6-9. For instance, the correlation module 6-106 of the computing device 6-10 correlating the subjective user state data 6-60 with the objective occurrence data 6-70* based, at least in part, on the historical data referencing module 6-243 referencing a historical sequential pattern associated with the user 6-20*, with other users 6-20*, and/or with a subset of the general population.

In some implementations, operation 6-904 may include an operation 6-908 for correlating the subjective user state data with the objective occurrence data based, at least in part, on referencing historical medical data as depicted in FIG. 6-9. For instance, the correlation module 6-106 of the computing device 6-10 correlating the subjective user state data 6-60 with the objective occurrence data 6-70* based, at least in part, on the historical data referencing module 6-243 referencing historical medical data (e.g., genetic, metabolome, or proteome information or medical records of the user 6-20* or of others related to, for example, diabetes or heart disease).

In various implementations, operation 6-902 may include an operation 6-910 for comparing the at least one sequential pattern to a second sequential pattern to determine whether the at least one sequential pattern at least substantially matches with the second sequential pattern as depicted in FIG. 6-9. For instance, the sequential pattern comparison module 6-248 of the computing device 6-10 comparing the at least one sequential pattern to a second sequential pattern to determine whether the at least one sequential pattern at least substantially matches with the second sequential pattern.

Operation 6-910, in some implementations, may further include an operation 6-912 for comparing the at least one sequential pattern to a second sequential pattern related to at least a second subjective user state associated with the user and a second objective occurrence to determine whether the at least one sequential pattern at least substantially matches with the second sequential pattern as depicted in FIG. 6-9. For instance, the sequential pattern comparison module 6-248 of the computing device 6-10 comparing the at least one sequential pattern to a second sequential pattern related to at least a previously reported second subjective user state associated with the user 6-20* and a second previously reported objective occurrence to determine whether the at least one sequential pattern at least substantially matches with the second sequential pattern.

For these implementations, the comparison of the first sequential pattern to the second sequential pattern may involve making certain comparisons, For example, comparing the first subjective user state to the second subjective user state to determine at least whether they are the same or different. Similarly, the first objective occurrence may be compared to the second objective occurrence to determine at least whether they are the same or different. The temporal relationship or the specific time sequencing between the incidence of the first subjective user state and the incidence of the first objective occurrence (e.g., as represented by the first sequential pattern) may then be compared to the temporal relationship or the specific time sequencing between the incidence of the second subjective user state and the incidence of the second objective occurrence (e.g., as represented by the second sequential pattern).

In some implementations, the correlation operation 6-808 of FIG. 6-8 may include an operation 6-914 for correlating the subjective user state data with the objective occurrence data at a server as depicted in FIG. 6-9. For instance, when the computing device 6-10 is a server (e.g., network server) and the correlation module 6-106 correlates the subjective user state data 6-60 with the objective occurrence data 6-70*.

In alternative implementations, the correlation operation 6-808 may include an operation 6-916 for correlating the subjective user state data with the objective occurrence data at a handheld device as depicted in FIG. 6-9. For instance, when the computing device 6-10 is a standalone device, such as a handheld device, and the correlation module 6-106 correlates the subjective user state data 6-60 with the objective occurrence data 6-70*.

In some implementations, the correlation operation 6-808 may include an operation 6-918 for correlating the subjective user state data with the objective occurrence data at a peer-to-peer network component device as depicted in FIG. 6-9. For instance, when the computing device 6-10 is a standalone device and is a peer-to-peer network component device, and the correlation module 6-106 correlates the subjective user state data 6-60 with the objective occurrence data 6-70*.

Referring back to FIG. 6-8, the presentation operation 6-810 may include one or more additional operations in various alternative implementations. For example, in some implementations, the presentation operation 6-810 may include an operation 6-1002 for indicating the one or more results of the correlating via a user interface as depicted in FIG. 6-10. For instance, when the computing device 6-10 is a standalone device such as a handheld device (e.g., cellular telephone, PDA, and so forth) or other mobile devices, and the user interface indication module 6-259 of the computing device 6-10 indicates the one or more results of the correlation operation performed by the correlation module 6-106 via a user interface 6-122 (e.g., display monitor or audio system including a speaker).

In some implementations, the presentation operation 6-810 may include an operation 6-1004 for transmitting the one or more results of the correlating via a network interface as depicted in FIG. 6-10. For instance, when the computing device 6-10 is a server and the network interface transmission module 6-258 of the computing device 6-10 transmits the one or more results of the correlation operation performed by the correlation module 6-106 via a network interface 6-120 (e.g., NIC).

In some implementations, the presentation operation 6-810 may include an operation 6-1006 for presenting an indication of a sequential relationship between the at least one subjective user state and the at least one objective occurrence as depicted in FIG. 6-10. For instance, the sequential relationship presentation module 6-260 of the computing device 6-10 presenting (e.g., either by transmitting via the network interface 6-120 or by indicating via the user interface 6-122) an indication of a sequential relationship between the at least one subjective user state (e.g., happy) and the at least one objective occurrence (e.g., playing with children).

In some implementations, the presentation operation 6-810 may include an operation 6-1008 for presenting a prediction of a future subjective user state associated with the user resulting from a future objective occurrence as depicted in FIG. 6-10. For instance, the prediction presentation module 6-261 of the computing device 6-10 presenting (e.g., either by transmitting via the network interface 6-120 or by indicating via the user interface 6-122) a prediction of a future subjective user state associated with the user 6-20* resulting from a future objective occurrence (e.g., “if you drink the 24 ounces of beer you ordered, you will have a hangover tomorrow”).

In some implementations, the presentation operation 6-810 may include an operation 6-1010 for presenting a prediction of a future subjective user state associated with the user resulting from a past objective occurrence as depicted in FIG. 6-10. For instance, the prediction presentation module 6-261 of the computing device 6-10 presenting (e.g., either by transmitting via the network interface 6-120 or by indicating via the user interface 6-122) a prediction of a future subjective user state associated with the user 6-20* resulting from a past objective occurrence (e.g., “you will have a stomach ache shortly because of the hot fudge sundae that you just ate”).

In some implementations, the presentation operation 6-810 may include an operation 6-1012 for presenting a past subjective user state associated with the user in connection with a past objective occurrence as depicted in FIG. 6-10. For instance, the past presentation module 6-262 of the computing device 6-10 presenting (e.g., either by transmitting via the network interface 6-120 or by indicating via the user interface 6-122) a past subjective user state associated with the user 6-20* in connection with a past objective occurrence (e.g., “reason why you had a headache this morning may be because you drank that 24 ounces of beer last night”).

In some implementations, the presentation operation 6-810 may include an operation 6-1014 for presenting a recommendation for a future action as depicted in FIG. 6-10. For instance, the recommendation module 6-263 of the computing device 6-10 presenting (e.g., either by transmitting via the network interface 6-120 or by indicating via the user interface 6-122) a recommendation for a future action (e.g., “you should buy something to calm your stomach tonight after you leave the bar tonight”).

In some implementations, operation 6-1014 may further include an operation 6-1016 for presenting a justification for the recommendation as depicted in FIG. 6-10. For instance, the justification module 6-264 of the computing device 6-10 presenting (e.g., either by transmitting via the network interface 6-120 or by indicating via the user interface 6-122) a justification for the recommendation (e.g., “you should buy something to calm your stomach tonight since you are drinking beer tonight, and the last time you drank beer, you had an upset stomach the next morning”).

FIG. 6-11 illustrates another operational flow 6-1100 in accordance with various embodiments. In some embodiments, operational flow may be particularly suited to be performed by a mobile device 6-30. Operational flow 6-1100 includes certain operations that may completely or substantially mirror certain operations included in the operational flow 6-800 of FIG. 6-8. These operations include, for example, a subjective user state data solicitation operation 6-1102, a subjective user state data acquisition operation 6-1104, and a presentation operation 6-1110 that corresponds to and completely or substantially mirror the subjective user state data solicitation operation 6-802, the subjective user state data acquisition operation 6-804, and the presentation operation 6-810, respectively, of FIG. 6-8.

In addition, operational flow 6-1100 may further include a subjective user state data transmission operation 6-1106 for transmitting the acquired subjective user state data including the data indicating incidence of at least one subjective user state associated with the user and a reception operation 6-1108 for receiving one or more results of correlation of the subjective user state data with objective occurrence data including data indicating the incidence of the at least one objective occurrence as depicted in FIG. 6-11. For instance, the subjective user state data transmission module 6-160 of the mobile device 6-30 transmitting (e.g., transmitting via at least one of the wireless network or wired network 6-40 to, for example, a network server such as computing device 6-10) the acquired subjective user state data 6-60 including the data indicating incidence of at least one subjective user state 6-60a associated with the user 6-20a. The correlation results reception module 6-162 may then receive (e.g., receive from the computing device 6-10) one or more results of correlation of the subjective user state data 6-60 with objective occurrence data 6-70* including data indicating the incidence of the at least one objective occurrence.

In various alternative implementations, the subjective user state data transmission operation 6-1106 may include one or more additional operations. For example, in some implementations, the subjective user state data transmission operation 6-1106 may include an operation 6-1202 for transmitting the acquired subjective user state data via at least one of a wireless network or a wired network as depicted in FIG. 6-12. For instance, the subjective user state data transmission module 6-160 of the mobile device 6-30 transmitting the acquired subjective user state data 6-60 via at least one of a wireless network or a wired network 6-40.

In some implementations, operation 6-1202 may include an operation 6-1204 for transmitting the acquired subjective user state data via one or more blog entries as depicted in FIG. 6-12. For instance, the subjective user state data transmission module 6-160 of the mobile device 6-30 transmitting the acquired subjective user state data 6-60 via one or more blog entries (e.g., microblog entries).

In some implementations, operation 6-1202 may include an operation 6-1206 for transmitting the acquired subjective user state data via one or more status reports as depicted in FIG. 6-12. For instance, the subjective user state data transmission module 6-160 of the mobile device 6-30 transmitting the acquired subjective user state data 6-60 via one or more status reports (e.g., social networking status reports).

In some implementations, operation 6-1202 may include an operation 6-1208 for transmitting the acquired subjective user state data via one or more electronic messages as depicted in FIG. 6-12. For instance, the subjective user state data transmission module 6-160 of the mobile device 6-30 transmitting the acquired subjective user state data 6-60 via one or more electronic messages (e.g., email message, IM messages, text messages, and so forth).

In some implementations, operation 6-1202 may include an operation 6-1210 for transmitting the acquired subjective user state data to a network server as depicted in FIG. 6-12. For instance, the subjective user state data transmission module 6-160 of the mobile device 6-30 transmitting the acquired subjective user state data 6-60 to a network server (e.g., computing device 6-10).

Referring back to FIG. 6-11, the reception operation 6-1108 may include one or more additional operations in various alternative implementations. For example, in some implementations, the reception operation 6-1108 may include an operation 6-1302 for receiving an indication of a sequential relationship between the at least one subjective user state and the at least one objective occurrence as depicted in FIG. 6-13. For instance, the correlation results reception module 6-162 of the mobile device 6-30 receiving (e.g., via wireless network and/or wired network 6-40) at least an indication of a sequential relationship between the at least one subjective user state and the at least one objective occurrence. For example, receiving an indication that the user 6-20a felt energized after jogging for thirty minutes.

In some implementations, the reception operation 6-1108 may include an operation 6-1304 for receiving a prediction of a future subjective user state associated with the user resulting from a future objective occurrence as depicted in FIG. 6-13. For instance, the correlation results reception module 6-162 of the mobile device 6-30 receiving (e.g., via wireless network and/or wired network 6-40) at least a prediction of a future subjective user state (e.g., feeling energized) associated with the user 6-20a resulting from a future objective occurrence (e.g., jogging for 30 minutes).

In some implementations, the reception operation 6-1108 may include an operation 6-1306 for receiving a prediction of a future subjective user state associated with the user resulting from a past objective occurrence as depicted in FIG. 6-13. For instance, the correlation results reception module 6-162 of the mobile device 6-30 receiving (e.g., via wireless network and/or wired network 6-40) at least a prediction of a future subjective user state (e.g., easing of pain) associated with the user 6-20a resulting from a past objective occurrence (e.g., previous ingestion of aspirin).

In some implementations, the reception operation 6-1108 may include an operation 6-1308 for receiving a past subjective user state associated with the user in connection with a past objective occurrence as depicted in FIG. 6-13. For instance, the correlation results reception module 6-162 of the mobile device 6-30 receiving (e.g., via wireless network and/or wired network 6-40) at least an indication of a past subjective user state (e.g., depression) associated with the user 6-20a in connection with a past objective occurrence (e.g., overcast weather).

In some implementations, the reception operation 6-1108 may include an operation 6-1310 for receiving a recommendation for a future action as depicted in FIG. 6-13. For instance, the correlation results reception module 6-162 of the mobile device 6-30 receiving (e.g., via wireless network and/or wired network 6-40) at least a recommendation for a future action (e.g., “you should go to sleep early”).

In certain implementations, operation 6-1310 may further include an operation 6-1312 for receiving a justification for the recommendation as depicted in FIG. 6-13. For instance, the correlation results reception module 6-162 of the mobile device 6-30 receiving (e.g., via wireless network and/or wired network 6-40) at least a justification for the recommendation (e.g., “last time you stayed up late, you were very tired the next morning”).

Referring back to FIG. 6-11. the process 6-1100 in various implementations may include a presentation operation 6-1110 for presenting the one or more results of the correlation. For example, the presentation module 6-108′ of the mobile device presenting the one or more results of the correlation received by the correlation results reception module 6-162. The presentation operation 6-1110 of FIG. 6-11 in some implementations may completely or substantially mirror the presentation operation 6-810 of FIG. 6-8. For instance, in some implementations, the presentation operation 6-1110 may include, similar to the presentation operation 6-810 of FIG. 6-8, an operation 6-1402 for indicating the one or more results of the correlation via a user interface as depicted in FIG. 6-14. For instance, the user interface indication module 6-259′ of the mobile device 6-30 indicating the one or more results of the correlation via a user interface 6-122′.

In some implementations, operation 6-1402 may further include an operation 6-1404 for indicating the one or more results of the correlation via a display device as depicted in FIG. 6-14. For instance, the user interface indication module 6-259′ of the mobile device 6-30 indicating the one or more results of the correlation via a display device (e.g., a display monitor such as a liquid crystal display or a touchscreen).

In some implementations, operation 6-1402 may include an operation 6-1406 for indicating the one or more results of the correlation via an audio device as depicted in FIG. 6-14. For instance, the user interface indication module 6-259′ of the mobile device 6-30 indicating the one or more results of the correlation via an audio device (e.g., a speaker).

### VIII: Hypothesis Based Solicitation of Data Indicating at Least One Objective Occurrence

In the following detailed description, reference is made to the accompanying drawings, which form a part hereof. In the drawings, similar symbols typically identify similar components, unless context dictates otherwise. The illustrative embodiments described in the detailed description, drawings, and claims are not meant to be limiting. Other embodiments may be utilized, and other changes may be made, without departing from the spirit or scope of the subject matter presented here.

A recent trend that is becoming increasingly popular in the computing/communication field is to electronically record one's feelings, thoughts, and other aspects of the person's everyday life onto an open diary. One place where such open diaries are maintained are at social networking sites commonly known as “blogs” where one or more users may report or post their thoughts and opinions on various topics, latest news, current events, and various other aspects of the users' everyday life. The process of reporting or posting blog entries is commonly referred to as blogging. Other social networking sites may allow users to update their personal information via, for example, social network status reports in which a user may report or post for others to view the latest status or other aspects of the user.

A more recent development in social networking is the introduction and explosive growth of microblogs in which individuals or users (referred to as “microbloggers”) maintain open diaries at microblog websites (e.g., otherwise known as “twitters”) by continuously or semi-continuously posting microblog entries. A microblog entry (e.g., “tweet”) is typically a short text message that is usually not more than 140 characters long. The microblog entries posted by a microblogger may report on any aspect of the microblogger's daily life.

The various things that are typically posted through microblog entries may be categorized into one of at least two possible categories. The first category of things that may be reported through microblog entries are “objective occurrences” that may or may not be associated with the microblogger. Objective occurrences that are associated with a microblogger may be any characteristic, event, happening, or any other aspects associated with or are of interest to the microblogger that can be objectively reported by the microblogger, a third party, or by a device. These things would include, for example, food, medicine, or nutraceutical intake of the microblogger, certain physical characteristics of the microblogger such as blood sugar level or blood pressure that can be objectively measured, daily activities of the microblogger observable by others or by a device, performance of the stock market (which the microblogger may have an interest in), and so forth. In some cases, objective occurrences may not be at least directly associated with a microblogger. Examples of such objective occurrences include, for example, external events that may not be directly related to the microblogger such as the local weather, activities of others (e.g., spouse or boss) that may directly or indirectly affect the microblogger, and so forth.

A second category of things that may be reported or posted through microblog entries include “subjective user states” of the microblogger. Subjective user states of a microblogger include any subjective state or status associated with the microblogger that can only be typically reported by the microblogger (e.g., generally cannot be reported by a third party or by a device). Such states including, for example, the subjective mental state of the microblogger (e.g., “I am feeling happy”), the subjective physical state of the microblogger (e.g., “my ankle is sore” or “my ankle does not hurt anymore” or “my vision is blurry”), and the subjective overall state of the microblogger (e.g., “I'm good” or “I'm well”). Note that the term “subjective overall state” as will be used herein refers to those subjective states that may not fit neatly into the other two categories of subjective user states described above (e.g., subjective mental states and subjective physical states). Although microblogs are being used to provide a wealth of personal information, they have thus far been primarily limited to their use as a means for providing commentaries and for maintaining open diaries.

In accordance with various embodiments, methods, systems, and computer program products are provided to, among other things, solicit and acquire at least a portion of objective occurrence data including data indicating incidence of at least one objective occurrence, the solicitation being directly or indirectly prompted based, at least in part on a hypothesis that links one or more subjective user states with one or more objective occurrences and in response to an incidence of at least one subjective user state associated with a user.

In various embodiments, a “hypothesis” may define one or more relationships or links between one or more subjective user states and one or more objective occurrences. In some embodiments, a hypothesis may be defined by a sequential pattern that indicates or suggests a temporal or specific time sequencing relationship between one or more subjective user states and one or more objective occurrences. In some cases, the one or more subjective user states associated with the hypothesis may be based on past incidences of one or more subjective user states that are associated with a user, that are associated with multiple users, that are associated with a sub-group of the general population, or that are associated with the general population. Similarly, the one or more objective occurrences associated with the hypothesis may be based on past incidences of objective occurrences.

In some cases, a hypothesis may be formulated when it is determined that a particular pattern of events (e.g., incidences of one or more subjective user states and one or more objective occurrences) occurs repeatedly with respect to a particular user, a group of users, a subset of the general population, or the general population. For example, a hypothesis may be formulated that suggests or predicts that a person will likely have an upset stomach after eating a hot fudge sundae when it is determined that multiple users had reported having an upset stomach after eating a hot fudge sundae. In other cases, a hypothesis may be formulated based, at least in part, on a single pattern of events and historical data related to such events. For instance, a hypothesis may be formulated when a person reports that he had a stomach ache after eating a hot fudge sundae, and historical data suggests that a segment of the population may not be able to digest certain nutrients included in a hot fudge sundae (e.g., the hypothesis would suggest or indicate that the person may get stomach aches whenever the person eats a hot fudge sundae).

The subjective user state data to be acquired by the methods, systems, and the computer program products may include data indicating the incidence of at least one subjective user state associated with a user. Such subjective user state data together with objective occurrence data including data indicating incidence of at least one objective occurrence may then be correlated. The results of the correlation may be presented in a variety of different forms and may, in some cases, confirm the veracity of the hypothesis. The results of the correlation, in various embodiments, may be presented to the user, to other users, or to one or more third parties as will be further described herein.

In some embodiments, the correlation of the acquired subjective user state data with the objective occurrence data may facilitate in determining a causal relationship between at least one objective occurrence (e.g., cause) and at least one subjective user state (e.g., result). For example, determining whenever a user eats a banana the user always or sometimes feels good. Note that an objective occurrence does not need to occur prior to a corresponding subjective user state but instead, may occur subsequent or at least partially concurrently with the incidence of the subjective user state. For example, a person may become “gloomy” (e.g., subjective user state) whenever it is about to rain (e.g., objective occurrence) or a person may become gloomy while (e.g., concurrently) it is raining. Further, in some cases, subjective user states may actually be the “cause” while an objective occurrence may be the “result.” For instance, when a user is angry (e.g., subjective user state), the user's angry state may cause his blood pressure (e.g., objective occurrence) to rise. Thus, a more relevant point to determine between subjective user states and objective occurrences is whether there are any links or relationships between the two types of events (e.g., subjective user states and objective occurrences).

An “objective occurrence data,” as will be described herein, may include data that indicate incidence of at least one objective occurrence. In some embodiments, an objective occurrence may be any physical characteristic, event, happenings, or any other aspect that may be associated with, is of interest to, or may somehow impact a user that can be objectively reported by at least a third party or a sensor device. Note, however, that an objective occurrence does not have to be actually reported by a sensor device or by a third party, but instead, may be reported by the user himself or herself (e.g., via microblog entries). Examples of objectively reported occurrences that could be indicated by the objective occurrence data include, for example, a user's food, medicine, or nutraceutical intake, the user's location at any given point in time, a user's exercise routine, a user's physiological characteristics such as blood pressure, social or professional activities, the weather at a user's location, activities associated with third parties, occurrence of external events such as the performance of the stock market, and so forth.

As briefly described earlier, the objective occurrence data to be acquired may include data that indicate the incidence or occurrence of at least one objective occurrence. In situations where the objective occurrence data to be acquired indicates multiple objective occurrences, each of the objective occurrences indicated by the acquired objective occurrence data may be solicited, while in other embodiments, only one or a subset of the objective occurrences indicated by the acquired objective occurrence data may be solicited.

A “subjective user state,” in contrast, is in reference to any subjective user state or status associated with a user (e.g., a blogger or microblogger) at any moment or interval in time that only the user can typically indicate or describe. Such states include, for example, the subjective mental state of the user (e.g., user is feeling sad), the subjective physical state (e.g., physical characteristic) of the user that only the user can typically indicate (e.g., a backache or an easing of a backache as opposed to blood pressure which can be reported by a blood pressure device and/or a third party), and the subjective overall state of the user (e.g., user is “good”).

Examples of subjective mental states include, for example, happiness, sadness, depression, anger, frustration, elation, fear, alertness, sleepiness, and so forth. Examples of subjective physical states include, for example, the presence, easing, or absence of pain, blurry vision, hearing loss, upset stomach, physical exhaustion, and so forth. Subjective overall states may include any subjective user states that cannot be easily categorized as a subjective mental state or as a subjective physical state. Examples of subjective overall states include, for example, the user “being good,” “bad,” “exhausted,” “lack of rest,” “wellness,” and so forth.

The term “correlating” as will be used herein may be in reference to a determination of one or more relationships between at least two variables. Alternatively, the term “correlating” may merely be in reference to the linking or associating of the at least two variables. In the following exemplary embodiments, the first variable is subjective user state data that indicates at least one subjective user state and the second variable is objective occurrence data that indicates at least one objective occurrence. In embodiments where the subjective user state data indicates multiple subjective user states, each of the subjective user states indicated by the subjective user state data may represent different incidences of the same or similar type of subjective user state (e.g., happiness). Alternatively, the subjective user state data may indicate multiple subjective user states that represent different incidences of different types of subjective user states (e.g., happiness and sadness).

Similarly, in some embodiments where the objective occurrence data may indicate multiple objective occurrences, each of the objective occurrences indicated by the objective occurrence data may represent different incidences of the same or similar type of objective occurrence (e.g., exercising). In alternative embodiments, however, each of the objective occurrences indicated by the objective occurrence data may represent different incidences of different types of objective occurrence (e.g., user exercising and user resting).

Various techniques may be employed for correlating subjective user state data with objective occurrence data in various alternative embodiments. For example, in some embodiments, the correlation of the objective occurrence data with the subjective user state data may be accomplished by determining a sequential pattern associated with at least one subjective user state indicated by the subjective user state data and at least one objective occurrence indicated by the objective occurrence data. In other embodiments, the correlation of the objective occurrence data with the subjective user state data may involve determining multiple sequential patterns associated with multiple subjective user states and multiple objective occurrences.

A sequential pattern, as will be described herein, may define time and/or temporal relationships between two or more events (e.g., one or more subjective user states and one or more objective occurrences). In order to determine a sequential pattern, at least a portion of objective occurrence data including data indicating incidence of at least one objective occurrence may be solicited, the solicitation being prompted based, at least in part, on a hypothesis linking one or more subjective user states with one or more objective occurrences and in response, at least in part, to an incidence of at least one subjective user state associated with a user.

For example, suppose a hypothesis suggests that a user or a group of users tend to be depressed whenever the weather is bad (e.g., cloudy or overcast weather). In some implementations, such a hypothesis may have been derived based on, for example, reported past events (e.g., reported past subjective user states of a user or a group of users and reported past objective occurrences). Based at least in part on the hypothesis and upon a user reporting being emotionally depressed, objective occurrence data including data indicating incidence of at least one objective occurrence may be solicited from, for example, the user or from one or more third party sources such as a weather reporting service. If the solicitation for the objective occurrence data is successful then the objective occurrence data may be acquired from the source (e.g., a user, one or more third party sources, or one or more sensors). If the acquired objective occurrence data indicates that the weather was indeed bad when the user felt depressed, then this may confirm the veracity of the hypothesis. On the other hand, if the data that is acquired after the solicitation indicates that the weather was good when the user was depressed, this may indicate that there is a weaker correlation or link between depression and bad weather.

As briefly described above, a hypothesis may be represented by a sequential pattern that may merely indicate or represent the temporal relationship or relationships between at least one subjective user state and at least one objective occurrence (e.g., whether the incidence or occurrence of at least one subjective user state occurred before, after, or at least partially concurrently with the incidence of the at least one objective occurrence). In alternative implementations, and as will be further described herein, a sequential pattern may indicate a more specific time relationship between the incidences of one or more subjective user states and the incidences of one or more objective occurrences. For example, a sequential pattern may represent the specific pattern of events (e.g., one or more objective occurrences and one or more subjective user states) that occurs along a timeline.

The following illustrative example is provided to describe how a sequential pattern associated with at least one subjective user state and at least one objective occurrence may be determined based, at least in part, on the temporal relationship between the incidence of at least one subjective user state and the incidence of at least one objective occurrence in accordance with some embodiments. For these embodiments, the determination of a sequential pattern may initially involve determining whether the incidence of the at least one subjective user state occurred within some predefined time increment from the incidence of the one objective occurrence. That is, it may be possible to infer that those subjective user states that did not occur within a certain time period from the incidence of an objective occurrence are not related or are unlikely related to the incidence of that objective occurrence.

For example, suppose a user during the course of a day eats a banana and also has a stomach ache sometime during the course of the day. If the consumption of the banana occurred in the early morning hours but the stomach ache did not occur until late that night, then the stomach ache may be unrelated to the consumption of the banana and may be disregarded. On the other hand, if the stomach ache had occurred within some predefined time increment, such as within 2 hours of consumption of the banana, then it may be concluded that there is a link between the stomach ache and the consumption of the banana. If so, a temporal relationship between the consumption of the banana and the occurrence of the stomach ache may be established. Such a temporal relationship may be represented by a sequential pattern. Such a sequential pattern may simply indicate that the stomach ache (e.g., a subjective user state) occurred after (rather than before or concurrently) the consumption of banana (e.g., an objective occurrence).

Other factors may also be referenced and examined in order to determine a sequential pattern and whether there is a relationship (e.g., causal relationship) between an incidence of an objective occurrence and an incidence of a subjective user state. These factors may include, for example, historical data (e.g., historical medical data such as genetic data or past history of the user or historical data related to the general population regarding, for example, stomach aches and bananas) as briefly described above.

In some implementations, a sequential pattern may be determined for multiple subjective user states and multiple objective occurrences. Such a sequential pattern may particularly map the exact temporal or time sequencing of the various events (e.g., subjective user states and objective occurrences). The determined sequential pattern may then be used to provide useful information to the user and/or third parties.

The following is another illustrative example of how subjective user state data may be correlated with objective occurrence data by determining multiple sequential patterns and comparing the sequential patterns with each other. Suppose, for example, a user such as a microblogger reports that the user ate a banana on a Monday. The consumption of the banana, in this example, is a reported incidence of a first objective occurrence associated with the user. The user then reports that 15 minutes after eating the banana, the user felt very happy. The reporting of the emotional state (e.g., felt very happy) is, in this example, a reported incidence of a first subjective user state. Thus, the reported incidence of the first objective occurrence (e.g., eating the banana) and the reported incidence of the first subjective user state (user felt very happy) on Monday may be represented by a first sequential pattern.

On Tuesday, the user reports that the user ate another banana (e.g., a second objective occurrence associated with the user). The user then reports that 20 minutes after eating the second banana, the user felt somewhat happy (e.g., a second subjective user state). Thus, the reported incidence of the second objective occurrence (e.g., eating the second banana) and the reported incidence of the second subjective user state (user felt somewhat happy) on Tuesday may be represented by a second sequential pattern. Under this scenario, the first sequential pattern may represent a hypothesis that links feeling happy or very happy (e.g., a subjective user state) with eating a banana (e.g., an objective occurrence). Alternatively, the first sequential pattern may merely represent historical data (e.g., historical sequential pattern). Note that in this example, the occurrences of the first subjective user state and the second subjective user state may be indicated by subjective user state data while the occurrences of the first objective occurrence and the second objective occurrence may be indicated by objective occurrence data.

In a slight variation of the above example, suppose the user had forgotten to report the consumption of the second banana on Tuesday but does report feeling somewhat happy on Tuesday. This may result in the user being asked, based at least in part on the reporting of the user feeling somewhat happy on Tuesday, and based at least in part on the hypothesis, as to whether the user ate anything around the time that the user felt happy on Tuesday. Upon the user indicating that the user ate a banana on Tuesday, a second sequential pattern may be determined based on the reported events of Tuesday.

In any event, by comparing the first sequential pattern with the second sequential pattern, the subjective user state data may be correlated with the objective occurrence data. Such a comparison may confirm the veracity of the hypothesis. In some implementations, the comparison of the first sequential pattern with the second sequential pattern may involve trying to match the first sequential pattern with the second sequential pattern by examining certain attributes and/or metrics. For example, comparing the first subjective user state (e.g., user felt very happy) of the first sequential pattern with the second subjective user state (e.g., user felt somewhat happy) of the second sequential pattern to see if they at least substantially match or are contrasting (e.g., being very happy in contrast to being slightly happy or being happy in contrast to being sad). Similarly, comparing the first objective occurrence (e.g., eating a banana) of the first sequential pattern may be compared to the second objective occurrence (e.g., eating of another banana) of the second sequential pattern to determine whether they at least substantially match or are contrasting.

A comparison may also be made to determine if the extent of time difference (e.g., 15 minutes) between the first subjective user state (e.g., user being very happy) and the first objective occurrence (e.g., user eating a banana) matches or are at least similar to the extent of time difference (e.g., 20 minutes) between the second subjective user state (e.g., user being somewhat happy) and the second objective occurrence (e.g., user eating another banana). These comparisons may be made in order to determine whether the first sequential pattern matches the second sequential pattern. A match or substantial match would suggest, for example, that a subjective user state (e.g., happiness) is linked to a particular objective occurrence (e.g., consumption of banana). In other words, confirming the hypothesis that happiness may be linked to the consumption of bananas.

As briefly described above, the comparison of the first sequential pattern with the second sequential pattern may include a determination as to whether, for example, the respective subjective user states and the respective objective occurrences of the sequential patterns are contrasting subjective user states and/or contrasting objective occurrences. For example, suppose in the above example the user had reported that the user had eaten a whole banana on Monday and felt very energetic (e.g., first subjective user state) after eating the whole banana (e.g., first objective occurrence). Suppose that the user also reported that on Tuesday he ate a half a banana instead of a whole banana and only felt slightly energetic (e.g., second subjective user state) after eating the half banana (e.g., second objective occurrence). In this scenario, the first sequential pattern (e.g., feeling very energetic after eating a whole banana) may be compared to the second sequential pattern (e.g., feeling slightly energetic after eating only a half of a banana) to at least determine whether the first subjective user state (e.g., being very energetic) and the second subjective user state (e.g., being slightly energetic) are contrasting subjective user states. Another determination may also be made during the comparison to determine whether the first objective occurrence (eating a whole banana) is in contrast with the second objective occurrence (e.g., eating a half of a banana).

In doing so, an inference may be made that eating a whole banana instead of eating only a half of a banana makes the user happier or eating more banana makes the user happier. Thus, the word “contrasting” as used here with respect to subjective user states refers to subjective user states that are the same type of subjective user states (e.g., the subjective user states being variations of a particular type of subjective user states such as variations of subjective mental states). Thus, for example, the first subjective user state and the second subjective user state in the previous illustrative example are merely variations of subjective mental states (e.g., happiness). Similarly, the use of the word “contrasting” as used here with respect to objective occurrences refers to objective states that are the same type of objective occurrences (e.g., consumption of food such as banana).

As those skilled in the art will recognize, a stronger correlation between the subjective user state data and the objective occurrence data could be obtained if a greater number of sequential patterns (e.g., if there was a third sequential pattern, a fourth sequential pattern, and so forth, that indicated that the user became happy or happier whenever the user ate bananas) are used as a basis for the correlation. Note that for ease of explanation and illustration, each of the exemplary sequential patterns to be described herein will be depicted as a sequential pattern of an incidence of a single subjective user state and an incidence of a single objective occurrence. However, those skilled in the art will recognize that a sequential pattern, as will be described herein, may also be associated with incidences or occurrences of multiple objective occurrences and/or multiple subjective user states. For example, suppose the user had reported that after eating a banana, he had gulped down a can of soda. The user then reported that he became happy but had an upset stomach. In this example, the sequential pattern associated with this scenario will be associated with two objective occurrences (e.g., eating a banana and drinking a can of soda) and two subjective user states (e.g., user having an upset stomach and feeling happy).

In some embodiments, and as briefly described earlier, the sequential patterns derived from subjective user state data and objective occurrence data may be based on temporal relationships between objective occurrences and subjective user states. For example, whether a subjective user state occurred before, after, or at least partially concurrently with an objective occurrence. For instance, a plurality of sequential patterns derived from subjective user state data and objective occurrence data may indicate that a user always has a stomach ache (e.g., subjective user state) after eating a banana (e.g., first objective occurrence).

FIGS. 7-1a and 7-1b illustrate an example environment in accordance with various embodiments. In the illustrated environment, an exemplary system 7-100 may include at least a computing device 7-10 (see FIG. 7-1b). The computing device 7-10, which may be a server (e.g., network server) or a standalone device, may be employed in order to, among other things, solicit and acquire at least a portion of objective occurrence data 7-70* including data indicating occurrence of at least one objective occurrence 7-71*, to acquire subjective user state data 7-60* including data indicating incidence of at least one subjective user state 7-61* associated with a user 7-20*, and to correlate the subjective user state data 7-60* with the objective occurrence data 7-70*. In embodiments in which the computing device 7-10 is a server, the exemplary system 7-100 may also include a mobile device 7-30 to at least solicit and acquire at least a portion of the objective occurrence data 7-70* including the data indicating incidence of at least one objective occurrence 7-71* in response to, for example, a request made by the computing device 7-10 for objective occurrence data 7-70*. Note that in the following, “*” indicates a wildcard. Thus, user 7-20* may indicate a user 7-20a or a user 7-20b of FIGS. 7-1a and 7-1b.

The term “standalone device” as referred to herein may be in reference to a device or system that is configured to acquire the subjective user state data 7-60* and the objective occurrence data 7-70* and performs a correlation operation to at least substantially correlate the subjective user state data 7-60* with the objective occurrence data 7-70*. In contrast, a mobile device 7-30, although may acquire both the subjective user state data 7-60* and the objective occurrence data 7-70* like a standalone device, the mobile device 7-30 does not perform a correlation operation in order to substantially correlate the subjective user state data 7-60* with the objective occurrence data 7-70*.

As previously indicated, in some embodiments, the computing device 7-10 may be a network server in which case the computing device 7-10 may communicate with a user 7-20a via a mobile device 7-30 and through a wireless and/or wired network 7-40. A network server, as will be described herein, may be in reference to a server located at a single network site or located across multiple network sites or a conglomeration of servers located at multiple network sites. The mobile device 7-30 may be a variety of computing/communication devices including, for example, a cellular phone, a personal digital assistant (PDA), a laptop, a desktop, or other types of computing/communication device that can communicate with the computing device 7-10. In some embodiments, the mobile device 7-30 may be a handheld device such as a cellular telephone, a smartphone, a Mobile Internet Device (MID), an Ultra Mobile Personal Computer (UMPC), a convergent device such as a personal digital assistant (PDA), and so forth.

In alternative embodiments, the computing device 7-10 may be a standalone computing device 7-10 (or simply “standalone device”) that communicates directly with a user 7-20b. For these embodiments, the computing device 7-10 may be any type of handheld device. In various embodiments, the computing device 7-10 (as well as the mobile device 7-30) may be a peer-to-peer network component device. In some embodiments, the computing device 7-10 and/or the mobile device 7-30 may operate via a Web 2.0 construct (e.g., Web 2.0 application 7-268).

In embodiments where the computing device 7-10 is a server, the computing device 7-10 may acquire the subjective user state data 7-60* indirectly from a user 7-20a via a network interface 7-120 and via mobile device 7-30. In alternative embodiments in which the computing device 7-10 is a standalone device such as a handheld device (e.g., cellular telephone, a smartphone, a MID, a UMPC, a PDA, and so forth), the subjective user state data 7-60* may be directly obtained from a user 7-20b via a user interface 7-122. As will be further described, the computing device 7-10 may solicit and acquire at least a portion of the objective occurrence data 7-70* (e.g., objective occurrence data 7-70a, objective occurrence data 7-70b, and/or objective occurrence data 7-70c) from one or more alternative sources. For example, in some situations, the computing device 7-10 may obtain objective occurrence data 7-70a from one or more third party sources 7-50 (e.g., content providers, other users, health care entities, businesses such as retail businesses, health fitness centers, social organizations, and so forth). In some situations, the computing device 7-10 may obtain objective occurrence data 7-70b from one or more sensors 7-35 (e.g., blood pressure sensors, glucometers, global positioning system (GPS), heart rate monitor, and so forth). In other situations, the computing device 7-10 (in the case where the computing device 7-10 is a server) may obtain objective occurrence data 7-70c from a user 7-20a via the mobile device 7-30 and through the wireless and/or wired network 7-40 or from a user 7-20b via user interface 7-122 (when the computing device 7-10 is a standalone device).

Note that in embodiments where the computing device 7-10 is a server, the computing device 7-10 may acquire the objective occurrence data 7-70a (e.g., from the one or more third party sources 7-50) and the objective occurrence data 7-70b (e.g. from the one or more sensors 7-35) via the mobile device 7-30. That is, in certain scenarios, only the user 7-20a (and the mobile device 7-30) may have access to such data in which case the computing device 7-10 may have to rely on the user 7-20a via the mobile device 7-30 in order to acquire the objective occurrence data 7-70a and 7-70b.

In order to acquire the objective occurrence data 7-70*, the computing device 7-10 may solicit at least a portion of the objective occurrence data 7-70* from one or more of the sources (e.g., user 7-20*, one or more third party sources 7-50, and/or one or more remote devices including one or more sensors 7-35). For example, in order to solicit at least a portion of the objective occurrence data 7-70a including soliciting data indicating incidence of at least one objective occurrence 7-71a, the computing device 7-10 may transmit a solicitation for objective occurrence data 7-75a to the one or more third party sources 7-50 via wireless and/or wired networks 7-40. In order to solicit at least a portion of the objective occurrence data 7-70b including soliciting data indicating incidence of at least one objective occurrence 7-71b, the computing device 7-10 may transmit a solicitation for objective occurrence data 7-75b to the one or more sensors 7-35. Finally, in order to solicit at least a portion of the objective occurrence data 7-70c including soliciting data indicating incidence of at least one objective occurrence 7-71c, the computing device 7-10 may transmit or indicate a solicitation for objective occurrence data 7-75c to a user 7-20*.

Note that an objective occurrence data 7-70* (e.g., objective occurrence data 7-70a, 7-70b, or 7-70c) may include data that indicates multiple incidences of objective occurrences. For ease of understanding and simplicity, however, each of the objective occurrence data 7-70* illustrated in FIG. 7-1a have been depicted as including only data indicating incidence of at least one objective occurrence 7-71* and data indicating incidence of at least a second objective occurrence 7-72*. However, in alternative implementations, each of the objective occurrence data 7-70* may also include data indicating incidence of at least a third objective occurrence, data indicating incidence of at least a fourth objective occurrence, and so forth. In various implementations, only a portion of the objective occurrence data 7-70* may need to be solicited. For example, in some implementations, only the data indicating incidence of at least one objective occurrence 7-71* may be solicited while the data indicating incidence of at least a second objective occurrence 7-72* may have be provided without any solicitation of such data.

In various embodiments, and regardless of whether the computing device 7-10 is a server or a standalone device, the computing device 7-10 may have access to at least one hypothesis 7-77. For example, in some situations, a hypothesis 7-77 may have been generated based on reported past events including past incidences of one or more subjective user states (which may be associated with a user 7-20*, a group of users 7-20*, a portion of the general population, or the general population) and past incidences of one or more objective occurrences. Such a hypothesis 7-77, in some instances, may be stored in a memory 7-140 to be easily accessible.

For ease of illustration and explanation, the following systems and operations to be described herein will be generally described in the context of the computing device 7-10 being a network server. However, those skilled in the art will recognize that these systems and operations may also be implemented when the computing device 7-10 is a standalone device such as a handheld device that may communicate directly with a user 7-20b.

The computing device 7-10, in various implementations, may be configured to solicit at least a portion of objective occurrence data 7-70* including soliciting data indicating incidence of at least one objective occurrence 7-71*. The solicitation of the data indicating incidence of at least one objective occurrence data 7-71* may be based, at least in part, on a hypothesis 7-77 that links one or more subjective user states with one or more objective occurrences and in response, at least in part, to an incidence of at least one subjective user state associated with a user 7-20*. In the case where the computing device 7-10 is a server, the computing device 7-10, based at least in part, on the hypothesis 7-77 and in response to the incidence of the at least one subjective user state associated with a user 7-20a, may transmit a solicitation or a request for the data indicating incidence of at least one objective occurrence 7-71* to the user 7-20a via a mobile device 7-30, to one or more remote devices including one or more sensors 7-35, and/or to one or more third party sources 7-50. Note that in some situations, the mobile device 7-30 may be solicited for the data indicating incidence of at least one objective occurrence 7-71c rather than soliciting from the user 7-20a. That is, in some situations, the solicited data may already have been provided to the mobile device 7-30 by the user 7-20a.

In the case where the computing device 7-10 is a standalone device, the computing device 7-10, may be configured to solicit objective occurrence data 7-70* including soliciting data indicating incidence of at least one objective occurrence 7-70c directly from a user 7-20b via a user interface 7-122, from one or more remote devices (e.g., one or more remote network servers or one or more sensors 7-35), and/or from one or more third party sources 7-50 via at least one of a wireless or wired network 7-40. After soliciting for the data indicating incidence of at least one objective occurrence 7-71*, the computing device 7-10 (e.g., either in the case where the computing device 7-10 is a server or in the case where the computing device 7-10 is a standalone device) may be further designed to acquire the data indicating incidence of at least one objective occurrence 7-71* as well as to acquire other data indicating other incidences of objective occurrences (e.g., data indicating incidence of at least a second objective occurrence 7-72*, and so forth). Examples of the types of objective occurrences that may be indicated by the objective occurrence data 7-70* include, for example, ingestions of food items, medicines, or nutraceutical by a user 7-20*, exercise routines executed a user 7-20*, social or recreational activities of a user 7-20*, activities performed by third parties, geographical locations of a user 7-20*, external events, physical characteristics of a user 7-20* at any given moment in time, and so forth.

In some embodiments, the computing device 7-10 may be configured to acquire subjective user state data 7-60* including data indicating incidence of at least one subjective user state 7-61* associated with a user 7-20*. For example, in embodiments where the computing device 7-10 is a server, the computing device 7-10 may acquire subjective user state data 7-60a including data indicating incidence of at least one subjective user state 7-61a associated with a user 7-20a. Such data may be acquired from the user 7-20a via a mobile device 7-30 or from other sources such as other network servers that may have previously stored such data and through at least one of a wireless network or a wired network 7-40. In embodiments where the computing device 7-10 is a standalone device, the computing device 7-10 may acquire subjective user state data 7-60b including data indicating incidence of at least one subjective user state 7-61b associated with a user 7-20b. Such data may be acquired from the user 7-20b via a user interface 7-122.

Note that in various alternative implementations, the subjective user state data 7-60* may include data that indicates multiple subjective user states associated with a user 7-20*. For ease of illustration and explanation, each of the subjective user state data 7-60a and the subjective user state data 7-60b illustrated in FIGS. 7-1a and 7-1b have been depicted as having only data indicating incidence of at least one subjective user state 7-61* (e.g., 7-61a or 7-61b) and data indicating incidence of at least a second subjective user state 7-62* (e.g., 7-62a or 7-62b). However, in alternate implementations, the subjective user state data 7-60* may further include data indicating incidences of at least a third, a fourth, a fifth, and so forth, subjective user states associated with a user 7-20*.

Examples of subjective user states that may be indicated by the subjective user state data 7-60* include, for example, subjective mental states of a user 7-20* (e.g., user 7-20* is sad or angry), subjective physical states of the user 7-20* (e.g., physical or physiological characteristic of the user 7-20* such as the presence, absence, elevating, or easing of a pain), subjective overall states of the user 7-20* (e.g., user 7-20* is “well”), and/or other subjective user states that only the user 7-20* can typically indicate.

The one or more sensors 7-35 illustrated in FIG. 7-1a may be designed for sensing or monitoring various aspects associated with the user 7-20a (or user 7-20b). For example, in some implementations, the one or more sensors 7-35 may include a global positioning system (GPS) device for determining the one or more locations of the user 7-20a and/or a physical activity sensor for measuring physical activities of the user 7-20a. Examples of a physical activity sensor include, for example, a pedometer for measuring physical activities of the user 7-20a. In certain implementations, the one or more sensors 7-35 may include one or more physiological sensor devices for measuring physiological characteristics of the user 7-20a. Examples of physiological sensor devices include, for example, a blood pressure monitor, a heart rate monitor, a glucometer, and so forth. In some implementations, the one or more sensors 7-35 may include one or more image capturing devices such as a video or digital camera.

In some embodiments, objective occurrence data 7-70c that may be acquired from a user 7-20a via the mobile device 7-30 (or from user 7-20b via user interface 7-122) may be acquired in various forms. For these embodiments, the objective occurrence data 7-70c may be in the form of blog entries (e.g., microblog entries), status reports, or other types of electronic entries (e.g., diary or calendar entries) or messages. In various implementations, the objective occurrence data 7-70c acquired from a user 7-20* may indicate, for example, activities (e.g., exercise or food or medicine intake) performed by the user 7-20*, certain physical characteristics (e.g., blood pressure or location) associated with the user 7-20*, or other aspects associated with the user 7-20* that the user 7-20* can report objectively. The objective occurrence data 7-70c may be in the form of a text data, audio or voice data, or image data.

In various embodiments, after acquiring the subjective user state data 7-60* including data indicating incidence of at least one subjective user state 7-61* and the objective occurrence data 7-70* including data indicating incidence of at least one objective occurrence 7-71*, the computing device 7-10 may be configured to correlate the acquired subjective user state data 7-60* with the acquired objective occurrence data 7-70* by, for example, determining whether there is a sequential relationship between the one or more subjective user states as indicated by the acquired subjective user state data 7-60* and the one or more objective occurrences indicated by the acquired objective occurrence data 7-70*.

In some embodiments, and as will be further explained in the operations and processes to be described herein, the computing device 7-10 may be further configured to present one or more results of the correlation. In various embodiments, the one or more correlation results 7-80 may be presented to a user 7-20* and/or to one or more third parties in various forms (e.g., in the form of an advisory, a warning, a prediction, and so forth). The one or more third parties may be other users 7-20* (e.g., microbloggers), health care providers, advertisers, and/or content providers.

As illustrated in FIG. 7-1b, computing device 7-10 may include one or more components and/or sub-modules. As those skilled in the art will recognize, these components and sub-modules may be implemented by employing hardware (e.g., in the form of circuitry such as application specific integrated circuit or ASIC, field programmable gate array or FPGA, or other types of circuitry), software, a combination of both hardware and software, or a general purpose computing device executing instructions included in a signal-bearing medium. In various embodiments, computing device 7-10 may include an objective occurrence data solicitation module 7-101, a subjective user state data acquisition module 7-102, an objective occurrence data acquisition module 7-104, a correlation module 7-106, a presentation module 7-108, a network interface 7-120 (e.g., network interface card or NIC), a user interface 7-122 (e.g., a display monitor, a touchscreen, a keypad or keyboard, a mouse, an audio system including a microphone and/or speakers, an image capturing system including digital and/or video camera, and/or other types of interface devices), one or more applications 7-126 (e.g., a web 2.0 application, a voice recognition application, and/or other applications), and/or memory 7-140, which may include at least one hypothesis 7-77 and historical data 7-78.

FIG. 7-2a illustrates particular implementations of the objective occurrence data solicitation module 7-101 of the computing device 7-10 of FIG. 7-1b. The objective occurrence data solicitation module 7-101 may be configured to solicit at least a portion of objective occurrence data 7-70* including soliciting data indicating incidence of at least one objective occurrence 7-71*. In various implementations, the solicitation of the data indicating incidence of at least one objective occurrence 7-71* by the objective occurrence data solicitation module 7-101 may be prompted based, at least in part, on a hypothesis 7-77 that links one or more objective occurrences with one or more subjective user states and in response, at least in part, to incidence of at least one subjective user state associated with a user 7-20*. For example, if an occurrence or incidence of a subjective user state (e.g., a hangover by a user 7-20*) has been reported, and if the hypothesis 7-77 links the same type of subjective user state (e.g., a hangover) to an objective occurrence (e.g., consumption of alcohol), then the solicitation of the data indicating incidence of at least one objective occurrence 7-71* may be to solicit data that would indicate an objective occurrence associated with the user 7-20* (e.g., consumption of alcohol) that occurred prior to the reported hangover by the user 7-20*.

The objective occurrence data solicitation module 7-101 may include one or more sub-modules in various alternative implementations. For example, in various implementations, the objective occurrence data solicitation module 7-101 may include a requesting module 7-202 configured to request for at least a portion of objective occurrence data 7-70* including requesting for data indicating incidence of at least one objective occurrence 7-71*. The requesting module 7-202 may further include one or more sub-modules. For example, in some implementations, such as when the computing device 7-10 is a standalone device, the requesting module 7-202 may include a user interface requesting module 7-204 configured to request for data indicating incidence of at least one objective occurrence 7-71* via a user interface 7-122. The user interface requesting module 7-204, in some cases, may further include a request indication module 7-205 configured to indicate a request for data indicating incidence of at least one objective occurrence 7-71* via the user interface 7-122 (e.g., indicating through at least a display system including a display monitor or touchscreen, or indicating via an audio system including a speaker).

In some implementations, such as when the computing device 7-10 is a server, the requesting module 7-202 may include a network interface requesting module 7-206 configured to request for at least data indicating incidence of at least one objective occurrence 7-71* via a network interface 7-120. The requesting module 7-202 may include other sub-modules in various alternative implementations. For example, in some implementations, the requesting module 7-202 may include a request transmission module 7-207 configured to transmit a request to be provided with at least data indicating incidence of at least one objective occurrence 7-71*. Alternatively or in the same implementations, the requesting module 7-202 may include a request access module 7-208 configured to transmit a request to have access to at least data indicating incidence of at least one objective occurrence 7-71*.

In the same or different implementations, the network interface requesting module 7-206 may include a configuration module 7-209 designed to configure (e.g., remotely configure) one or more remote devices (e.g., a remote network server, a mobile device 7-30, or some other network device) to provide at least data indicating incidence of at least one objective occurrence 7-71*. In the same or different implementations, the requesting module 7-202 may include a directing/instructing module 7-210 configured to direct or instruct a remote device (e.g., transmitting directions or instructions to the remote device such as a remote network server or the mobile device 7-30) to provide at least data indicating incidence of at least one objective occurrence 7-71*.

The requesting module 7-202 may include other sub-modules in various alternative implementations. These sub-modules may be included with the requesting module 7-202 regardless of whether the computing device 7-10 is a server or a standalone device. For example, in some implementations, the requesting module 7-202 may include a motivation provision module 7-212 configured to provide, among other things, a motivation for requesting for the data indicating incidence of at least one objective occurrence 7-71*. In the same or different implementations, the requesting module 7-202 may include a selection request module 7-214 configured to, among other things, request a user 7-20* for a selection of an objective occurrence from a plurality of indicated alternative objective occurrences (e.g., asking the user 7-20* through the user interface 7-122* to select from alternative choices of “bad weather,” “good weather,” “consumed alcohol,” “jogging for one hour,” and so forth).

In the same or different implementations, the requesting module 7-202 may include a confirmation request module 7-216 configured to request confirmation of an incidence of at least one objective occurrence (e.g., asking a user 7-20* through the user interface 7-122* whether the user 7-20* ate spicy foods for dinner). In the same or different implementations, the requesting module 7-202 may include a time/temporal element request module 7-218 configured to, among other things, request for an indication of a time or temporal element associated with an incidence of at least one objective occurrence (e.g., asking the user 7-20* via the user interface 7-122* whether the user 7-20* ate lunch before, after, or during when the user 7-20* felt tired?).

In various implementations, the objective occurrence data solicitation module 7-101 of FIG. 7-2a may include a hypothesis referencing module 7-220 configured to, among other things, reference at least one hypothesis 7-77, which in some cases, may be stored in memory 7-140.

FIG. 7-2b illustrates particular implementations of the subjective user state data acquisition module 7-102 of the computing device 7-10 of FIG. 7-1b. In brief, the subjective user state data acquisition module 7-102 may be designed to, among other things, acquire subjective user state data 7-60* including data indicating at least one subjective user state 7-61* associated with a user 7-20*. In various embodiments, the subjective user state data acquisition module 7-102 may be further designed to acquire data indicating at least a second subjective user state 7-62* associated with the user 7-20*, data indicating at least a third subjective user state associated with the user 7-20*, and so forth. In some embodiments, the subjective user state data acquisition module 7-102 may include a subjective user state data reception module 7-224 configured to receive the subjective user state data 7-60* including the data indicating incidence of the at least one subjective user state 7-61* associated with the user 7-20*, the data indicating incidence of the at least a second subjective user state 7-62* associated with the user 7-20*, and so forth. In some implementations, the subjective user state data reception module 7-224 may further include a user interface reception module 7-226 configured to receive, via a user interface 7-122, subjective user state data 7-60* including at least the data indicating incidence of at least one subjective user state 7-61* associated with a user 7-20*. In the same or different implementations, the subjective user state data reception module 7-224 may include a network interface reception module 7-227 configured to receive, via a network interface 7-120, subjective user state data 7-60* including at least the data indicating incidence of at least one subjective user state 7-61* associated with a user 7-20*.

The subjective user state data acquisition module 7-102, in various implementations, may include a time data acquisition module 7-228 configured to acquire (e.g., receive or generate) time and/or temporal elements associated with one or more objective occurrences. In some implementations, the time data acquisition module 7-228 may include a time stamp acquisition module 7-230 for acquiring (e.g., acquiring either by receiving or by generating) one or more time stamps associated with one or more objective occurrences In the same or different implementations, the time data acquisition module 7-228 may include a time interval acquisition module 7-231 for acquiring (e.g., either by receiving or generating) indications of one or more time intervals associated with one or more objective occurrences.

FIG. 7-2c illustrates particular implementations of the objective occurrence data acquisition module 7-104 of the computing device 7-10 of FIG. 7-1b. In brief, the objective occurrence data acquisition module 7-104 may be configured to, among other things, acquire objective occurrence data 7-70* including data indicating incidence of at least one objective occurrence 7-71*, data indicating incidence of at least a second objective occurrence 7-72*, and so forth. As further illustrated, in some implementations, the objective occurrence data acquisition module 7-104 may include an objective occurrence data reception module 7-234 configured to, among other things, receive objective occurrence data 7-70* from a user 7-20*, from one or more third party sources 7-50 (e.g., one or more third parties), or from one or more remote devices such as one or more sensors 7-35 or one or more remote network servers.

The objective occurrence data reception module 7-234, in turn, may further include one or more sub-modules. For example, in some implementations, such as when the computing device 7-10 is a standalone device, the objective occurrence data reception module 7-234 may include a user interface data reception module 7-235 configured to receive objective occurrence data 7-70* via a user interface 7-122 (e.g., a keyboard, a mouse, a touchscreen, a microphone, an image capturing device such as a digital camera, and so forth). In some cases, the objective occurrence data 7-70* (e.g., objective occurrence data 7-70c) to be received via the user interface 7-122 may have been provided by and originate from a user 7-20b. In other cases, the objective occurrence data 7-70* to be received via the user interface 7-122 may have originated from one or more third party sources 7-50 or from one or more remote sensors 7-35 and provided by user 7-20b. In some implementations, such as when the computing device 7-10 is a server, the objective occurrence data reception module 7-234 may include a network interface data reception module 7-236 configured to, among other things, receive objective occurrence data 7-70* from at least one of a wireless network or a wired network 7-40. The network interface data reception module 7-236 may directly or indirectly receive the objective occurrence data 7-70* from a user 7-20a, from one or more third party sources 7-50, or from one or more remote devices such as one or more sensors 7-35.

Turning now to FIG. 7-2d illustrating particular implementations of the correlation module 7-106 of the computing device 7-10 of FIG. 7-1b. The correlation module 7-106 may be configured to, among other things, correlate subjective user state data 7-60* with objective occurrence data 7-70* based, at least in part, on a determination of at least one sequential pattern of at least one objective occurrence and at least one subjective user state. In various embodiments, the correlation module 7-106 may include a sequential pattern determination module 7-242 configured to determine one or more sequential patterns of one or more incidences of subjective user states and one or more incidences of objective occurrences.

The sequential pattern determination module 7-242, in various implementations, may include one or more sub-modules that may facilitate in the determination of one or more sequential patterns. As depicted, the one or more sub-modules that may be included in the sequential pattern determination module 7-242 may include, for example, a “within predefined time increment determination” module 7-244, a temporal relationship determination module 7-246, a subjective user state and objective occurrence time difference determination module 7-245, and/or a historical data referencing module 7-243. In brief, the within predefined time increment determination module 7-244 may be configured to determine whether an incidence of at least one subjective user state associated with a user 7-20* occurred within a predefined time increment from an incidence of at least one objective occurrence. For example, determining whether a user 7-20* “feeling bad” (i.e., a subjective user state) occurred within ten hours (i.e., predefined time increment) of eating a large chocolate sundae (i.e., an objective occurrence). Such a process may be used in order to filter out events that are likely not related or to facilitate in determining the strength of correlation between subjective user state data 7-60* and objective occurrence data 7-70*. For example, if the user 7-20* “feeling bad” occurred more than 10 hours after eating the chocolate sundae, then this may indicate a weaker correlation between a subjective user state (e.g., feeling bad) and an objective occurrence (e.g., eating a chocolate sundae).

The temporal relationship determination module 7-246 of the sequential pattern determination module 7-242 may be configured to determine the temporal relationships between one or more incidences of subjective user states associated with a user 7-20* and one or more incidences of objective occurrences. For example, this determination may entail determining whether an incidence of a particular subjective user state (e.g., sore back) occurred before, after, or at least partially concurrently with an incidence of a particular objective occurrence (e.g., sub-freezing temperature).

The subjective user state and objective occurrence time difference determination module 7-245 of the sequential pattern determination module 7-242 may be configured to determine the extent of time difference between an incidence of at least one subjective user state associated with a user 7-20* and an incidence of at least one objective occurrence. For example, determining how long after taking a particular brand of medication (e.g., objective occurrence) did a user 7-20* feel “good” (e.g., subjective user state).

The historical data referencing module 7-243 of the sequential pattern determination module 7-242 may be configured to reference historical data 7-78 in order to facilitate in determining sequential patterns. For example, in various implementations, the historical data 7-78 that may be referenced may include, for example, general population trends (e.g., people having a tendency to have a hangover after drinking or ibuprofen being more effective than aspirin for toothaches in the general population), medical information such as genetic, metabolome, or proteome information related to the user 7-20* (e.g., genetic information of the user 7-20* indicating that the user 7-20* is susceptible to a particular subjective user state in response to occurrence of a particular objective occurrence), or historical sequential patterns such as known sequential patterns of the general population or of the user 7-20* (e.g., people tending to have difficulty sleeping within five hours after consumption of coffee). In some instances, such historical data 7-78 may be useful in associating one or more incidences of subjective user states associated with a user 7-20* with one or more incidences of objective occurrences.

In some embodiments, the correlation module 7-106 may include a sequential pattern comparison module 7-248. As will be further described herein, the sequential pattern comparison module 7-248 may be configured to compare two or more sequential patterns with respect to each other to determine, for example, whether the sequential patterns at least substantially match each other or to determine whether the sequential patterns are contrasting sequential patterns.

As depicted in FIG. 7-2d, in various implementations, the sequential pattern comparison module 7-248 may further include one or more sub-modules that may be employed in order to, for example, facilitate in the comparison of different sequential patterns. For example, in various implementations, the sequential pattern comparison module 7-248 may include one or more of a subjective user state equivalence determination module 7-250, an objective occurrence equivalence determination module 7-251, a subjective user state contrast determination module 7-252, an objective occurrence contrast determination module 7-253, a temporal relationship comparison module 7-254, and/or an extent of time difference comparison module 7-255. In some implementations, the sequential pattern comparison module 7-248 may be employed in order to, for example, confirm the veracity of a hypothesis 7-77.

The subjective user state equivalence determination module 7-250 of the sequential pattern comparison module 7-248 may be configured to determine whether subjective user states associated with different sequential patterns are at least substantially equivalent. For example, the subjective user state equivalence determination module 7-250 may determine whether a first subjective user state of a first sequential pattern is equivalent to a second subjective user state of a second sequential pattern. For instance, suppose a user 7-20* reports that on Monday he had a stomach ache (e.g., first subjective user state) after eating at a particular restaurant (e.g., a first objective occurrence), and suppose further that the user 7-20* again reports having a stomach ache (e.g., a second subjective user state) after eating at the same restaurant (e.g., a second objective occurrence) on Tuesday, then the subjective user state equivalence determination module 7-250 may be employed in order to compare the first subjective user state (e.g., stomach ache) with the second subjective user state (e.g., stomach ache) to determine whether they are equivalent. Note that in this example, the first sequential pattern may represent a hypothesis 7-77 linking a subjective user state (e.g., stomach ache) to an objective occurrence (e.g., eating at a particular restaurant).

In contrast, the objective occurrence equivalence determination module 7-251 of the sequential pattern comparison module 7-248 may be configured to determine whether objective occurrences of different sequential patterns are at least substantially equivalent. For example, the objective occurrence equivalence determination module 7-251 may determine whether a first objective occurrence of a first sequential pattern is equivalent to a second objective occurrence of a second sequential pattern. For instance, in the above example, the objective occurrence equivalence determination module 7-251 may compare eating at the particular restaurant on Monday (e.g., first objective occurrence) with eating at the same restaurant on Tuesday (e.g., second objective occurrence) in order to determine whether the first objective occurrence is equivalent to the second objective occurrence.

In some implementations, the sequential pattern comparison module 7-248 may include a subjective user state contrast determination module 7-252 that may be configured to determine whether subjective user states associated with different sequential patterns are contrasting subjective user states. For example, the subjective user state contrast determination module 7-252 may determine whether a first subjective user state of a first sequential pattern is a contrasting subjective user state from a second subjective user state of a second sequential pattern. To illustrate, suppose a user 7-20* reports that he felt very “good” (e.g., first subjective user state) after jogging for an hour (e.g., first objective occurrence) on Monday, but reports that he felt “bad” (e.g., second subjective user state) when he did not exercise (e.g., second objective occurrence) on Tuesday, then the subjective user state contrast determination module 7-252 may compare the first subjective user state (e.g., feeling good) with the second subjective user state (e.g., feeling bad) to determine that they are contrasting subjective user states.

In some implementations, the sequential pattern comparison module 7-248 may include an objective occurrence contrast determination module 7-253 that may be configured to determine whether objective occurrences of different sequential patterns are contrasting objective occurrences. For example, the objective occurrence contrast determination module 7-253 may determine whether a first objective occurrence of a first sequential pattern is a contrasting objective occurrence from a second objective occurrence of a second sequential pattern. For instance, in the previous example, the objective occurrence contrast determination module 7-253 may compare the “jogging” on Monday (e.g., first objective occurrence) with the “no jogging” on Tuesday (e.g., second objective occurrence) in order to determine whether the first objective occurrence is a contrasting objective occurrence from the second objective occurrence. Based on the contrast determination, an inference may be made that the user 7-20* may feel better by jogging rather than by not jogging at all.

In some embodiments, the sequential pattern comparison module 7-248 may include a temporal relationship comparison module 7-254 that may be configured to make comparisons between different temporal relationships of different sequential patterns. For example, the temporal relationship comparison module 7-254 may compare a first temporal relationship between a first subjective user state and a first objective occurrence of a first sequential pattern with a second temporal relationship between a second subjective user state and a second objective occurrence of a second sequential pattern in order to determine whether the first temporal relationship at least substantially matches the second temporal relationship.

For example, referring back to the earlier restaurant example, suppose the user 7-20* eating at the particular restaurant (e.g., first objective occurrence) and the subsequent stomach ache (e.g., first subjective user state) on Monday represents a first sequential pattern while the user 7-20* eating at the same restaurant (e.g., second objective occurrence) and the subsequent stomach ache (e.g., second subjective user state) on Tuesday represents a second sequential pattern. In this example, the occurrence of the stomach ache after (rather than before or concurrently) eating at the particular restaurant on Monday represents a first temporal relationship associated with the first sequential pattern while the occurrence of a second stomach ache after (rather than before or concurrently) eating at the same restaurant on Tuesday represents a second temporal relationship associated with the second sequential pattern.

Under such circumstances, the temporal relationship comparison module 7-254 may compare the first temporal relationship to the second temporal relationship in order to determine whether the first temporal relationship and the second temporal relationship at least substantially match (e.g., stomach aches in both temporal relationships occurring after eating at the restaurant). Such a match may result in the inference that a stomach ache is associated with eating at the particular restaurant and may, in some instances, confirm the veracity of a hypothesis 7-77.

In some implementations, the sequential pattern comparison module 7-248 may include an extent of time difference comparison module 7-255 that may be configured to compare the extent of time differences between incidences of subjective user states and incidences of objective occurrences of different sequential patterns. For example, the extent of time difference comparison module 7-255 may compare the extent of time difference between incidence of a first subjective user state and incidence of a first objective occurrence of a first sequential pattern with the extent of time difference between incidence of a second subjective user state and incidence of a second objective occurrence of a second sequential pattern. In some implementations, the comparisons may be made in order to determine that the extent of time differences of the different sequential patterns at least substantially or proximately match.

In some embodiments, the correlation module 7-106 may include a strength of correlation determination module 7-256 for determining a strength of correlation between subjective user state data 7-60* and objective occurrence data 7-70*. In some implementations, the strength of correlation may be determined based, at least in part, on the results provided by the other sub-modules of the correlation module 7-106 (e.g., the sequential pattern determination module 7-242, the sequential pattern comparison module 7-248, and their sub-modules).

FIG. 7-2e illustrates particular implementations of the presentation module 7-108 of the computing device 7-10 of FIG. 7-1b. In various implementations, the presentation module 7-108 may be configured to present, for example, one or more results of the correlation operations performed by the correlation module 7-106. In some implementations, the presentation module 7-108 may include a network interface transmission module 7-258 configured to transmit one or more results of a correlation operation performed by the correlation module 7-106 via a network interface 7-120 (e.g., NIC). In the same or different implementations, the presentation module 7-108 may include a user interface indication module 7-259 configured to indicate one or more results of a correlation operation performed by the correlation module 7-106 via a user interface 7-122 (e.g., display monitor or audio system including a speaker).

The presentation module 7-108 may be particularly designed to present one or more results of a correlation operation performed by the correlation module 7-106 in a variety of different forms in various alternative embodiments. For example, in some implementations, the presentation of the one or more results may entail the presentation module 7-108 presenting to the user 7-20* (or some other third party) an indication of a sequential relationship between a subjective user state and an objective occurrence associated with the user 7-20* (e.g., “whenever you eat a banana, you have a stomach ache”). In alternative implementations, other ways of presenting the results of the correlation may be employed. For example, in various alternative implementations, a notification may be provided to notify past tendencies or patterns associated with a user 7-20*. In some implementations, a notification of a possible future outcome may be provided. In other implementations, a recommendation for a future course of action based on past patterns may be provided. These and other ways of presenting the correlation results will be described in the processes and operations to be described herein.

In order to present the one or more results of a correlation operation performed by the correlation module 7-106, the presentation module 7-108 may include one or more sub-modules. For example, in some implementations, the presentation module 7-108 may include a sequential relationship presentation module 7-260 configured to present an indication of a sequential relationship between at least one subjective user state of a user 7-20* and at least one objective occurrence. In the same or different implementations, the presentation module 7-108 may include a prediction presentation module 7-261 configured to present a prediction of a future subjective user state of a user 7-20* resulting from a future objective occurrence associated with the user 7-20*. In the same or different implementations, the prediction presentation module 7-261 may also be designed to present a prediction of a future subjective user state of a user 7-20* resulting from a past objective occurrence associated with the user 7-20*. In some implementations, the presentation module 7-108 may include a past presentation module 7-262 that is designed to present a past subjective user state of a user 7-20* in connection with a past objective occurrence associated with the user 7-20*.

In some implementations, the presentation module 7-108 may include a recommendation module 7-263 configured to present a recommendation for a future action based, at least in part, on the results of a correlation of subjective user state data 7-60* with objective occurrence data 7-70* as performed by the correlation module 7-106. In certain implementations, the recommendation module 7-263 may further include a justification module 7-264 for presenting a justification for the recommendation presented by the recommendation module 7-263. In some implementations, the presentation module 7-108 may include a strength of correlation presentation module 7-266 for presenting an indication of a strength of correlation between subjective user state data 7-60* and objective occurrence data 7-70*.

In various embodiments, the computing device 7-10 of FIG. 7-1b may include a network interface 7-120 that may facilitate in communicating with a user 7-20a, with one or more sensors 7-35, and/or with one or more third party sources 7-50 via a wireless and/or wired network 7-40. For example, in embodiments where the computing device 7-10 is a server, the computing device 7-10 may include a network interface 7-120 that may be configured to receive from the user 7-20a subjective user state data 7-60a. In some embodiments, objective occurrence data 7-70a, 7-70b, and/or 7-70c may also be received through the network interface 7-120. Examples of a network interface 7-120 includes, for example, a network interface card (NIC) or other devices or systems for communicating through at least one of a wireless network or wired network 7-40.

The computing device 7-10 may also include a memory 7-140 for storing various data. For example, in some embodiments, memory 7-140 may be employed in order to store a hypothesis 7-77 and/or historical data 7-78. In some implementations, the historical data 7-78 may include historical subjective user state data of a user 7-20* that may indicate one or more past subjective user states of the user 7-20*, and historical objective occurrence data that may indicate one or more past objective occurrences. In the same or different implementations, the historical data 7-78 may include historical medical data of a user 7-20* (e.g., genetic, metoblome, proteome information), population trends, historical sequential patterns derived from general population, and so forth. Examples of a memory 7-140 include, for example, a mass storage device, read only memory (ROM), programmable read only memory (PROM), erasable programmable read-only memory (EPROM), random access memory (RAM), flash memory, synchronous random access memory (SRAM), dynamic random access memory (DRAM), and so forth.

In various embodiments, the computing device 7-10 may include a user interface 7-122 to communicate directly with a user 7-20b. For example, in embodiments in which the computing device 7-10 is a standalone device such as a handheld device (e.g., cellular telephone, smartphone, PDA, and so forth), the user interface 7-122 may be configured to directly receive from the user 7-20b subjective user state data 7-60* and/or objective occurrence data 7-70*. In some implementations, the user interface 7-122 may also be designed to visually or audibly present the results of correlating subjective user state data 7-60* with objective occurrence data 7-70*. The user interface 7-122 may include, for example, one or more of a display monitor, a touch screen, a key board, a key pad, a mouse, an audio system including a microphone and/or one or more speakers, an imaging system including a digital or video camera, and/or other user interface devices.

FIG. 7-2f illustrates particular implementations of the one or more applications 7-126 of FIG. 7-1b. For these implementations, the one or more applications 7-126 may include, for example, one or more communication applications 7-269 such as a text messaging application and/or an audio messaging application including a voice recognition system application. In some implementations, the one or more applications 7-126 may include a web 2.0 application 7-268 to facilitate communication via, for example, the World Wide Web.

The various features and characteristics of the components, modules, and sub-modules of the computing device 7-10 presented thus far will be described in greater detail with respect to the processes and operations to be described herein. Note that the subjective user state data 7-60* may be in a variety of forms including, for example, text messages (e.g., blog entries, microblog entries, instant messages, text email messages, and so forth), audio messages, and/or images (e.g., an image capturing user's facial expression or gestures).

Referring to FIG. 7-2g illustrating particular implementations of the mobile device 7-30 of FIG. 7-1a. The mobile device 7-30 includes some modules that are the same as some of the modules that may be included in the computing device 7-10. These components may have the same features and perform the same or similar types of functions as those of their corresponding counterparts in the computing device 7-10. For example, and just like the computing device 7-10, the mobile device 7-30 may include an objective occurrence data solicitation module 7-101′, a subjective user state data acquisition module 7-102′, an objective occurrence data acquisition module 7-104′, a presentation module 7-108′, a network interface 7-120′, a user interface 7-122′, one or more application [s] 7-126′ (e.g., including a Web 2.0 application), and/or memory 7-140′ (including historical data 7-78′).

In various implementations, in addition to these components, the mobile device 7-30 may include an objective occurrence data transmission module 7-160 that is configured to transmit (e.g., transmit via a wireless and/or wired network 7-40) at least a portion of objective occurrence data 7-70* including data indicating incidence of at least one objective occurrence 7-71*. In some implementations, the subjective user state data 7-60a and/or at least a portion of the objective occurrence data 7-70* may be transmitted to a network server such as computing device 7-10. In the same or different implementations, the mobile device 7-30 may include a correlation results reception module 7-162 that may be configured to receive, via a wireless and/or wired network 7-40, results of correlation of subjective user state data 7-60* with objective occurrence data 7-70*. In some implementations, such a correlation may have been performed at a network server (e.g., computing device 7-10).

FIG. 7-2h illustrates particular implementations of the objective occurrence data solicitation module 7-101′ of the mobile device 7-30 of FIG. 7-2g. As depicted, the objective occurrence data solicitation module 7-101′ may include some components that are the same or similar to some of the components that may be included in the objective occurrence data solicitation module 7-101 of the computing device 7-10 as illustrated in FIG. 7-2a. For example, the objective occurrence data solicitation module 7-101′ may include a requesting module 7-202′ that further includes a user interface requesting module 7-204′ (and a request indication module 7-205′ included with the user interface requesting module 7-204′), a network interface requesting module 7-206′, a request transmission module 7-207′, a request access module 7-208′, a configuration module 7-209′, a directing/instructing module 7-210′, a motivation provision module 7-212′, a selection request module 7-214′, a confirmation request module 7-216′ and a time/temporal element request module 7-218′. As will be further described herein, these components may have the same features and perform the same functions as their counterparts in the computing device 7-10.

In addition, and unlike the computing device 7-10, the objective occurrence data solicitation module 7-101′ of the mobile device 7-30 may include a request to solicit reception module 7-270 that may be configured to receive a request to solicit data indicating incidence of at least one objective occurrence 7-71*. Such a request, in some implementations, may be remotely generated (e.g. remotely generated at the computing device 7-10) based, at least in part, on a hypothesis 7-77 and, in some cases, in response, at least in part, to an incidence of at least one objective occurrence.

FIG. 7-2i illustrates particular implementations of the subjective user state data acquisition module 7-102′ of the mobile device 7-30 of FIG. 7-2g. The subjective user state data acquisition module 7-102′ may include some components that are the same or similar to some of the components that may be included in the subjective user state data acquisition module 7-102 (see FIG. 7-2b) of the computing device 7-10. These components may perform the same or similar functions as their counterparts in the subjective user state data acquisition module 7-102 of the computing device 7-10. For example, the subjective user state data acquisition module 7-102′ may include a subjective user state data reception module 7-224′ and a time data acquisition module 7-228′. Similar to their counterparts in the computing device 7-10 and performing similar roles, the subjective user state data reception module 7-224′ may include a user interface reception module 7-226′ while the time data acquisition module 7-228′ may include a time stamp acquisition module 7-230′ and a time interval acquisition module 7-231′.

Referring to FIG. 7-2j illustrating particular implementations of the objective occurrence data acquisition module 7-104′ of the mobile device 7-30 of FIG. 7-2g. The objective occurrence data acquisition module 7-104′ may include the same or similar type of components that may be included in the objective occurrence data acquisition module 7-104 (see FIG. 7-2c) of the computing device 7-10. For example, the objective occurrence data acquisition module 7-104′ may include an objective occurrence data reception module 7-234′ (which may further include a user interface data reception module 7-235′ and/or a network interface data reception module 7-236′).

FIG. 7-2k illustrates particular implementations of the presentation module 7-108′ of the mobile device 7-30 of FIG. 7-2g. In various implementations, the presentation module 7-108′ may include some of the same components that may be included in the presentation module 7-108 (see FIG. 7-2e) of the computing device 7-10. For example, the presentation module 7-108′ may include a user interface indication module 7-259′, a sequential relationship presentation module 7-260′, a prediction presentation module 7-261′, a past presentation module 7-262′, a recommendation module 7-263′ (which may further include a justification module 7-264′), and/or a strength of correlation presentation module 7-266′.

FIG. 7-2l illustrates particular implementations of the one or more applications 7-126′ of the mobile device 7-30 of FIG. 7-2g. In various implementations, the one or more applications 7-126′ may include the same or similar applications included in the one or more applications 7-126 of the computing device 7-10 (see FIG. 7-20. For example, the one or more applications 7-126′ may include one or more communication applications 7-269′ and a web 2.0 application 7-268′ performing similar functions as their counterparts in the computing device 7-10.

A more detailed discussion of these components (e.g., modules and interfaces) that may be included in the mobile device 7-30 and those that may be included in the computing device 7-10 will be provided with respect to the processes and operations to be described herein.

FIG. 7-3 illustrates an operational flow 7-300 representing example operations related to, among other things, hypothesis based solicitation and acquisition of at least a portion of objective occurrence data 7-70* including data indicating incidence of at least one objective occurrence 7-71*. In some embodiments, the operational flow 7-300 may be executed by, for example, the computing device 7-10 of FIG. 7-1b, which may be a server or a standalone device. Alternatively, the operation flow 7-300 may be executed by, for example, the mobile device 7-30 of FIG. 7-1a.

In FIG. 7-3 and in the following figures that include various examples of operational flows, discussions and explanations may be provided with respect to the above-described exemplary environment of FIGS. 7-1a and 7-1b, and/or with respect to other examples (e.g., as provided in FIGS. 7-2a-7-21) and contexts. However, it should be understood that the operational flows may be executed in a number of other environments and contexts, and/or in modified versions of FIGS. 7-1a, 7-1b, and 7-2a-7-2l. Also, although the various operational flows are presented in the sequence(s) illustrated, it should be understood that the various operations may be performed in other orders other than those which are illustrated, or may be performed concurrently.

Further, in FIG. 7-3 and in following figures, various operations may be depicted in a box-within-a-box manner. Such depictions may indicate that an operation in an internal box may comprise an optional example embodiment of the operational step illustrated in one or more external boxes. However, it should be understood that internal box operations may be viewed as independent operations separate from any associated external boxes and may be performed in any sequence with respect to all other illustrated operations, or may be performed concurrently.

In any event, after a start operation, the operational flow 7-300 may move to an objective occurrence data solicitation operation 7-302 for soliciting, based at least in part on a hypothesis that links one or more objective occurrences with one or more subjective user states and in response at least in part to an incidence of at least one subjective user state associated with a user, at least a portion of objective occurrence data including data indicating incidence of at least one objective occurrence. For instance, the objective occurrence data solicitation module 7-101 of the computing device 7-10 or the objective occurrence data solicitation module 7-101′ of the mobile device 7-30 soliciting, based at least in part on a hypothesis 7-77 (e.g., the computing device 7-10 referencing a hypothesis 7-77, or the mobile device 7-30 receiving a request for soliciting at least a portion of objective occurrence data from the computing device 7-10, the request being remotely generated by the computing device 7-10 and sent to the mobile device 7-30 based at least in part on a hypothesis 7-77) that links one or more objective occurrences with one or more subjective user states (e.g., a group of users 7-20* ingesting a particular type of medicine such as aspirin, and the subsequent subjective physical states, such as pain relief, associated with the group of users 7-20*) and in response at least in part to an incidence of at least one subjective user state (e.g., pain relief by a user 7-20*) associated with a user 7-20*, at least a portion of objective occurrence data 7-70* including data indicating incidence of at least one objective occurrence 7-71* (e.g., ingestion of aspirin by user 7-20*).

Note that the solicitation of at least a portion of the objective occurrence data 7-70*, as described above, may or may not be in reference to solicitation of particular data that indicates an incidence or occurrence of a particular or particular type of objective occurrence. That is, in some embodiments, the solicitation of at least a portion of the objective occurrence data 7-70* may be in reference to solicitation for objective occurrence data 7-70* including data indicating incidence of any objective occurrence with respect to, for example, a particular point in time or time interval or with respect to a incidence of a particular subjective user state associated with the user 7-20*. While in other embodiments, the solicitation of at least a portion of the objective occurrence data 7-70* may involve soliciting for data indicating occurrence of a particular or particular type of objective occurrence.

The term “soliciting,” as will be used herein, may be in reference to direct or indirect solicitation of (e.g., requesting to be provided with, requesting to access, gathering of, or other methods of being provided with or being allowed access to) at least a portion of objective occurrence data 7-70* from one or more sources. The sources for at least a portion of the objective occurrence data 7-70* may be a user 7-20* (e.g., providing objective occurrence data 7-70c via mobile device 7-30), a mobile device 7-30 (e.g., mobile device 7-30 may have previously obtained the objective occurrence data 7-70c from the user 7-20a or from other sources), one or more network servers (not depicted), one or more third party sources 7-50 (e.g., providing objective occurrence data 7-70a), or one or more sensors 7-35 (e.g., providing objective occurrence data 7-70b).

For example, if the computing device 7-10 is a server, then the computing device 7-10 may indirectly solicit at least a portion of objective occurrence data 7-70c from a user 7-20a by transmitting, for example, a request for at least the portion of the objective occurrence data 7-70c to the mobile device 7-30, which in turn may solicit at least the portion of the objective occurrence data 7-70c from the user 7-20a. Alternatively, such data may have already been provided to the mobile device 7-30, in which case the mobile device 7-30 merely provides for or allows access to such data. Note that the objective occurrence data 7-70c that may be provided by the mobile device 7-30 may have originally been obtained from the user 7-20a, from one or more third party sources 7-50, and/or from one or more remote network devices (e.g., sensors 7-35 or network servers).

In some situations, at least a portion of objective occurrence data 7-70* may be stored in a network server (not depicted), and such a network server may be solicited for at least portion of the objective occurrence data 7-70*. In other implementations, objective occurrence data 7-70a or 7-70b may be solicited from one or more third party sources 7-50 (e.g., one or more third parties or one or more network devices such as servers that are associated with one or more third parties) or from one or more sensors 7-35. In yet other implementations in which the computing device 7-10 is a standalone device, such as a handheld device to be used directly by a user 7-20b, the computing device 7-10 may directly solicit, for example, the objective occurrence data 7-70c from the user 7-20b.

Operational flow 7-300 may further include an objective occurrence data acquisition operation 7-304 for acquiring the objective occurrence data including the data indicating incidence of at least one objective occurrence. For instance, the objective occurrence data acquisition module 7-104* of the computing device 7-10 or the mobile device 7-30 acquiring (e.g., receiving or accessing by the computing device 7-10 or by the mobile device 7-30) the objective occurrence data 7-70* including the data indicating incidence of at least one objective occurrence 7-71*.

In various implementations, the objective occurrence data solicitation operation 7-302 of FIG. 7-3 may include one or more additional operations as illustrated in FIGS. 7-4a, 7-4b, 7-4c, 7-4d, 7-4e, 7-4f, 7-4g, 7-4h, 7-4i, and 7-4j. For example, in some implementations the objective occurrence data solicitation operation 7-302 may include a requesting operation 7-402 for requesting for the data indicating incidence of at least one objective occurrence from the user as depicted in FIG. 7-4a. For instance, the requesting module 7-202* of the computing device 7-10 or the mobile device 7-30 (e.g., the requesting module 7-202 of the computing device 7-10 or the requesting module 7-202′ of the mobile device 7-30) requesting (e.g., transmitting or indicating a request by the computing device 7-10 or by the mobile device 7-30) for the data indicating incidence of at least one objective occurrence 7-71* (e.g., 7-71a, 7-71b, or 7-71c) from the user 7-20* (e.g., user 7-20a or user 7-20b).

In various implementations, the requesting operation 7-402 may further include one or more additional operations. For example, in some implementations, the requesting operation 7-402 may include an operation 7-403 for requesting for the data indicating incidence of at least one objective occurrence via a user interface as depicted in FIG. 7-4a. For example, the user interface requesting module 7-204* of the computing device 7-10 (e.g., when the computing device 7-10 is a standalone device) or the mobile device 7-30 requesting for the data indicating incidence of at least one objective occurrence 7-71c via a user interface 7-122* (e.g. an audio device including one or more speakers or a display device such as a display monitor or a touchscreen).

Operation 7-403, in turn, may further include an operation 7-404 for indicating a request for the data indicating incidence of at least one objective occurrence through at least a display device as depicted in FIG. 7-4a. For example, the request indication module 7-205* of the computing device 7-10 or the mobile device 7-30 indicating (e.g., displaying) a request for the data indicating incidence of at least one objective occurrence 7-71c (e.g., what was consumed for dinner today by the user 7-20* or whether the user 7-20* exercised today?) through at least a display device (e.g., a display monitor such as a liquid crystal display or a touchscreen).

In the same or different implementations, operation 7-403 may include an operation 7-405 for indicating a request for the data indicating incidence of at least one objective occurrence through at least an audio device as depicted in FIG. 7-4a. For example, the request indication module 7-205* of the computing device 7-10 or the mobile device 7-30 indicating a request for the data indicating incidence of at least one objective occurrence 7-70* (e.g., what was the humidity today or was a hot fudge sundae consumed today?) through at least an audio device (e.g., an audio system including one or more speakers).

In some implementations, the requesting operation 7-402 may include an operation 7-406 for requesting for the data indicating incidence of at least one objective occurrence via at least one of a wireless network or a wired network as depicted in FIG. 7-4a. For example, the network interface requesting module 7-206* of the computing device 7-10 or the mobile device 7-30 requesting for the data indicating incidence of at least one objective occurrence 7-71* (e.g., data indicating blood pressure of the user 7-20* or data indicating an exercise routine executed by the user 7-20*) via at least one of a wireless network or a wired network 7-40. Note that in the case where the computing device 7-10 is executing operation 7-406, the data indicating incidence of at least one objective occurrence 7-71* may be requested from the user 7-20*, from one or more third party sources 7-50, from one or more sensors 7-35, or from other network devices (e.g., network servers). In the case where the mobile device 7-30 is executing operation 7-406, the data indicating incidence of at least one objective occurrence 7-71* may be requested from a user 7-20a, from one or more third party sources 7-50, from one or more sensors 7-35, or from other network devices (e.g., network servers).

In various implementations, the requesting operation 7-402 may include an operation 7-407 for requesting the user to select an objective occurrence from a plurality of indicated alternative objective occurrences as depicted in FIG. 7-4a. For example, the selection request module 7-214* of the computing device 7-10 or the mobile device 7-30 requesting the user 7-20* to select an objective occurrence from a plurality of indicating alternative objective occurrences (e.g., as indicated via a user interface 7-122*). For example, requesting a user 7-20* to select one objective occurrence from a list that includes cloudy weather, sunny weather, high humidity, low humidity, high or low blood pressure, ingestion of a medicine such as aspirin, ingestion of a particular type of food item such as beer, an exercise routine such as jogging, and so forth.

In some implementations, operation 7-407 may further include an operation 7-408 for requesting the user to select an objective occurrence from a plurality of indicated alternative contrasting objective occurrences as depicted in FIG. 7-4a. For example, the selection request module 7-214* of the computing device 7-10 or the mobile device 7-30 requesting the user 7-20* (e.g., either user 7-20a or user 7-20b) to select an objective occurrence from a plurality of indicated alternative contrasting objective occurrences (e.g., as indicated via a user interface 7-122*). For example, requesting a user 7-20* to select one objective occurrence from a list of indicated alternative contrasting objective occurrences such as running for 1 hour, running for 30 minutes, running for 15 minutes, walking for 1 hour, walking for 30 minutes, sitting for 1 hour, sitting for 30 minutes, and so forth.

In some implementations, the requesting operation 7-402 may include an operation 7-409 for requesting the user to confirm incidence of the at least one objective occurrence as depicted in FIG. 7-4a. For example, the confirmation request module 7-216* of the computing device 7-10 or the mobile device 7-30 requesting the user 7-20* to confirm incidence of the at least one objective occurrence (e.g., did user 7-20* have a salad for lunch today?).

In some implementations, the requesting operation 7-402 may include an operation 7-410 for requesting the user to provide an indication of an incidence of at least one objective occurrence that occurred during a specified point in time as depicted in FIG. 7-4a. For example, the requesting module 7-202* of the computing device 7-10 or the mobile device 7-30 requesting the user 7-20* (e.g., either user 7-20a or user 7-20b) to provide an indication of an incidence of at least one objective occurrence that occurred during a specified point in time (e.g., asking the user 7-20* whether the user 7-20* ate dinner at a particular Mexican restaurant at 8 PM?).

In some implementations, the requesting operation 7-402 may include an operation 7-411 for requesting the user to provide an indication of an incidence of at least one objective occurrence that occurred during a specified time interval as depicted in FIG. 7-4a. For example, the requesting module 7-202* of the computing device 7-10 or the mobile device 7-30 requesting the user 7-20* to provide an indication of an incidence of at least one objective occurrence that occurred during a specified time interval (e.g., asking the user 7-20* whether the user 7-20* slept between 11 PM to 7 AM?).

In some implementations, the requesting operation 7-402 may include an operation 7-412 for requesting the user to indicate an incidence of at least one objective occurrence with respect to the incidence of the at least one subjective user state associated with the user as depicted in FIG. 7-4b. For instance, the requesting module 7-202* of the computing device 7-10 or the mobile device 7-30 requesting the user 7-20* (e.g., either user 7-20a or user 7-20b) to indicate an incidence of at least one objective occurrence with respect to the incidence of the at least one subjective user state associated with the user 7-20*. For example, asking the user 7-20* to indicate what the weather was like when the user 7-20* felt depressed.

In various implementations, the requesting operation 7-402 may include an operation 7-413 for providing a motivation for requesting for the data indicating incidence of at least one objective occurrence as depicted in FIG. 7-4b. For instance, the motivation provision module 7-212* of the computing device 7-10 or the mobile device 7-30 providing a motivation for requesting for the data indicating incidence of at least one objective occurrence 7-71c (e.g., last time the user 7-20* was depressed, the weather was very bad).

In some implementations, operation 7-413 may include an operation 7-414 for providing a motivation for requesting for the data indicating incidence of at least one objective occurrence, the motivation relating to the link between the one or more objective occurrences with the one or more subjective user states as provided by the hypothesis as depicted in FIG. 7-4b. For instance, the motivation provision module 7-212* of the computing device 7-10 or the mobile device 7-30 providing a motivation for requesting for the data indicating incidence of at least one objective occurrence 7-71c, the motivation relating to the link between the one or more objective occurrences with the one or more subjective user states as provided by the hypothesis 7-77 (e.g., hypothesis linking depression with bad weather).

In various implementations, the solicitation operation 7-302 of FIG. 7-3 may include a requesting operation 7-415 for requesting for the data indicating incidence of at least one objective occurrence from one or more third party sources as depicted in FIG. 7-4b. For instance, the requesting module 7-202* of the computing device 7-10 or the mobile device 7-30 requesting (e.g., via at least one of a wireless network or a wired network 7-40) for the data indicating incidence of at least one objective occurrence 7-71a from one or more third party sources 7-50.

In various implementations, the requesting operation 7-415 may include one or more additional operations. For example, in some implementations, the requesting operation 7-415 may include an operation 7-416 for requesting for the data indicating incidence of at least one objective occurrence from one or more third party sources via at least one of a wireless network or a wired network as depicted in FIG. 7-4b. For instance, the network interface requesting module 7-206* of the computing device 7-10 or the mobile device 7-30 requesting for the data indicating incidence of at least one objective occurrence 7-71a from one or more third party sources 7-50 via at least one of a wireless network or a wired network 7-40.

In some implementations, the requesting operation 7-415 may include an operation 7-417 for requesting the one or more third party sources to confirm incidence of the at least one objective occurrence as depicted in FIG. 7-4b. For instance, the confirmation request module 7-216* of the computing device 7-10 or the mobile device 7-30 requesting the one or more third party sources 7-50* to confirm incidence of the at least one objective occurrence (e.g., asking a fitness center or a network device associated with the fitness center whether the user 7-20* exercised on the treadmill for 30 minutes on Tuesday).

In some implementations, the requesting operation 7-415 may include an operation 7-418 for requesting the one or more third party sources to provide an indication of an incidence of at least one objective occurrence that occurred during a specified point in time as depicted in FIG. 7-4b. For instance, the requesting module 7-202* of the computing device 7-10 or the mobile device 7-30 requesting the one or more third party sources 7-50 to provide an indication of an incidence of at least one objective occurrence that occurred during a specified point in time. For example, requesting from a content provider an indication of the local weather for 10 AM Tuesday).

In some implementations, the requesting operation 7-415 may include an operation 7-419 for requesting the one or more third party sources to provide an indication of an incidence of at least one objective occurrence that occurred during a specified time interval as depicted in FIG. 7-4b. For instance, the requesting module 7-202* of the computing device 7-10 or the mobile device 7-30 requesting the one or more third party sources 7-50 to provide an indication of an incidence of at least one objective occurrence that occurred during a specified time interval. For example, requesting from a content provider for an indication of the performance of the stock market between 9 AM and 1 PM on Tuesday.

In some implementations, the requesting operation 7-415 may include an operation 7-420 for requesting the one or more third party sources to provide an indication of an incidence of at least one objective occurrence that occurred with respect to the incidence of the at least one subjective user state associated with the user as depicted in FIG. 7-4c. For instance, the requesting module 7-202* of the computing device 7-10 or the mobile device 7-30 requesting the one or more third party sources 7-50 (e.g., spouse of user 7-20*) to provide an indication of an incidence of at least one objective occurrence (e.g., excessive snoring while sleeping) that occurred with respect to the incidence of the at least one subjective user state (e.g., sleepiness or fatigue) associated with the user 7-20*.

In some implementations, the requesting operation 7-415 may include an operation 7-421 for requesting for the data indicating incidence of at least one objective occurrence from one or more content providers as depicted in FIG. 7-4c. For instance, the requesting module 7-202* of the computing device 7-10 or the mobile device 7-30 requesting for the data indicating incidence of at least one objective occurrence 7-71a from one or more content providers (e.g., weather channel, internet news service, and so forth).

In some implementations, the requesting operation 7-415 may include an operation 7-422 for requesting for the data indicating incidence of at least one objective occurrence from one or more other users as depicted in FIG. 7-4c. For instance, the requesting module 7-202* of the computing device 7-10 or the mobile device 7-30 requesting for the data indicating incidence of at least one objective occurrence 7-71a from one or more other users (e.g., spouse, relatives, friends, or co-workers of user 7-20*).

In some implementations, the requesting operation 7-415 may include an operation 7-423 for requesting for the data indicating incidence of at least one objective occurrence from one or more health care entities as depicted in FIG. 7-4c. For instance, the requesting module 7-202* of the computing device 7-10 or the mobile device 7-30 requesting for the data indicating incidence of at least one objective occurrence 7-71a from one or more health care entities (e.g., medical doctors, dentists, health care facilities, clinics, hospitals, and so forth).

In some implementations, the requesting operation 7-415 may include an operation 7-424 for requesting for the data indicating incidence of at least one objective occurrence from one or more health fitness entities as depicted in FIG. 7-4c. For instance, the requesting module 7-202* of the computing device 7-10 or the mobile device 7-30 requesting for the data indicating incidence of at least one objective occurrence 7-71a from one or more health fitness entities (e.g., fitness gyms or fitness instructors).

In some implementations, the requesting operation 7-415 may include an operation 7-425 for requesting for the data indicating incidence of at least one objective occurrence from one or more business entities as depicted in FIG. 7-4c. For instance, the requesting module 7-202* of the computing device 7-10 or the mobile device 7-30 requesting for the data indicating incidence of at least one objective occurrence 7-71a from one or more business entities (e.g., user 7-20* place of employment, merchandiser, airlines, and so forth).

In some implementations, the requesting operation 7-415 may include an operation 7-426 for requesting for the data indicating incidence of at least one objective occurrence from one or more social groups as depicted in FIG. 7-4c. For instance, the requesting module 7-202* of the computing device 7-10 or the mobile device 7-30 requesting for the data indicating incidence of at least one objective occurrence 7-71a from one or more social groups (e.g., PTA, social networking groups, societies, clubs, and so forth).

In some implementations, the requesting operation 7-415 may include an operation 7-427 for requesting for the data indicating incidence of at least one objective occurrence from one or more third party sources via a network interface as depicted in FIG. 7-4c. For instance, the requesting module 7-202* of the computing device 7-10 or the mobile device 7-30 requesting for the data indicating incidence of at least one objective occurrence 7-71a from one or more third party sources 7-50 via a network interface 7-120*.

In some implementations, the requesting operation 7-415 may include an operation 7-428 for requesting for the data indicating incidence of at least one objective occurrence from one or more third party sources through at least one of a wireless network or a wired network as depicted in FIG. 7-4c. For instance, the requesting module 7-202* of the computing device 7-10 or the mobile device 7-30 requesting for the data indicating incidence of at least one objective occurrence 7-71a from one or more third party sources 7-50 through at least one of a wireless network or a wired network 7-40.

In various implementations, the solicitation operation 7-302 of FIG. 7-3 may include an operation 7-429 for requesting for the data indicating incidence of at least one objective occurrence from one or more remote devices as depicted in FIG. 7-4d. For instance, the network interface requesting module 7-206* of the computing device 7-10 or the mobile device 7-30 requesting for the data indicating incidence of at least one objective occurrence 7-71b from one or more remote devices (e.g., network servers, sensors 7-35, mobile devices including mobile device 7-30, and/or other network devices).

Operation 7-429, in turn, may include one or more additional operations in various alternative implementations. For example, in some implementations, operation 7-429 may include an operation 7-430 for transmitting a request to be provided with the data indicating incidence of at least one objective occurrence to the one or more remote devices as depicted in FIG. 7-4d. For instance, the request transmission module 7-207* of the computing device 7-10 or the mobile device 7-30 transmitting a request to be provided with the data indicating incidence of at least one objective occurrence 7-71b to one or more remote devices (e.g., network servers, sensors 7-35, mobile devices including mobile device 7-30, and/or other network devices).

In some implementations, operation 7-429 may include an operation 7-431 for transmitting a request to have access to the data indicating incidence of at least one objective occurrence to the one or more remote devices as depicted in FIG. 7-4d. For instance, the request access module 7-208* of the computing device 7-10 or the mobile device 7-30 transmitting a request to have access to the data indicating incidence of at least one objective occurrence 7-71b to the one or more remote devices (e.g., network servers, sensors 7-35, mobile devices including mobile device 7-30 in the case where operation 7-431 is performed by the computing device 7-10 and the computing device 7-10 is a server, and/or other network devices).

In some implementations, operation 7-429 may include an operation 7-432 for configuring one or more remote devices to provide the data indicating incidence of at least one objective occurrence as depicted in FIG. 7-4d. For instance, the configuration module 7-209* of the computing device 7-10 or the mobile device 7-30 configuring, via at least one of a wireless network or wired network 7-40, one or more remote devices (e.g., network servers, mobile devices including mobile device 7-30, sensors 7-35, or other network devices) to provide the data indicating incidence of at least one objective occurrence 7-71b.

In some implementations, operation 7-429 may include an operation 7-433 for directing or instructing the one or more remote devices to provide the data indicating incidence of at least one objective occurrence as depicted in FIG. 7-4d. For instance, the directing/instructing module 7-210* of the computing device 7-10 or the mobile device 7-30 directing or instructing, via at least one of a wireless network or wired network 7-40, the one or more remote devices (e.g., network servers, mobile devices including mobile device 7-35, sensors 7-35, or other network devices) to provide the data indicating incidence of at least one objective occurrence 7-71b.

In some implementations, operation 7-429 may include an operation 7-434 for requesting for the data indicating incidence of at least one objective occurrence from one or more sensors as depicted in FIG. 7-4d. For instance, the network interface requesting module 7-206* of the computing device 7-10 or the mobile device 7-30 requesting for the data indicating incidence of at least one objective occurrence 7-71b from one or more sensors 7-35 (e.g., GPS, physiological measuring device such as a blood pressure device or glucometer).

In some implementations, operation 7-429 may include an operation 7-435 for requesting for the data indicating incidence of at least one objective occurrence from one or more network servers as depicted in FIG. 7-4d. For instance, the network interface requesting module 7-206* of the computing device 7-10 or the mobile device 7-30 requesting for the data indicating incidence of at least one objective occurrence 7-71b from one or more network servers, which may have previously obtained such data.

In some implementations, operation 7-429 may include an operation 7-436 for requesting for the data indicating incidence of at least one objective occurrence from one or more mobile devices as depicted in FIG. 7-4d. For instance, the network interface requesting module 7-206* of the computing device 7-10 or the mobile device 7-30 requesting for the data indicating incidence of at least one objective occurrence 7-71b from one or more mobile devices (e.g., cellular telephone, PDA, laptop or notebook, and so forth) including, for example, mobile device 7-30.

In some implementations, operation 7-429 may include an operation 7-437 for requesting for the data indicating incidence of at least one objective occurrence from one or more remote devices through at least one of a wireless network or a wired network as depicted in FIG. 7-4d. For instance, the network interface requesting module 7-206* of the computing device 7-10 or the mobile device 7-30 requesting for the data indicating incidence of at least one objective occurrence 7-71b from one or more remote network devices through at least one of a wireless network or a wired network 7-40.

In some implementations, operation 7-429 may include an operation 7-438 for requesting for the data indicating incidence of at least one objective occurrence from one or more remote devices via a network interface as depicted in FIG. 7-4d. For instance, the network interface requesting module 7-206* of the computing device 7-10 or the mobile device 7-30 requesting for the data indicating incidence of at least one objective occurrence 7-71b from one or more remote network devices via a network interface 7-120*.

In various implementations, the solicitation operation 7-302 of FIG. 7-3 may include an operation 7-439 for requesting to be provided with a time stamp associated with the incidence of at least one objective occurrence as depicted in FIG. 7-4e. For instance, the time/temporal element request module 7-218* of the computing device 7-10 or the mobile device 7-30 requesting to be provided with a time stamp associated with the incidence of at least one objective occurrence (e.g., requesting a time stamp associated with the user 7-20* consuming a particular medication).

In some implementations, the solicitation operation 7-302 may include an operation 7-440 for requesting to be provided with an indication of a time interval associated with the incidence of at least one objective occurrence as depicted in FIG. 7-4e. For instance, the time/temporal element request module 7-218* of the computing device 7-10 or the mobile device 7-30 requesting to be provided with an indication of a time interval associated with the incidence of at least one objective occurrence (e.g., requesting to be provided with an indication that indicates the time interval in which the user 7-20* exercised on the treadmill).

In some implementations, the solicitation operation 7-302 may include an operation 7-441 for requesting to be provided with an indication of a temporal relationship between the incidence of the at least one subjective user state associated with the user and the incidence of the at least one objective occurrence as depicted in FIG. 7-4e. For instance, the time/temporal element request module 7-218* of the computing device 7-10 or the mobile device 7-30 requesting to be provided with an indication of a temporal relationship between the incidence of the at least one subjective user state associated with the user 7-20* and the incidence of the at least one objective occurrence (e.g., did user 7-20* eat at the Mexican restaurant before, after, or as the user 7-20* was having the upset stomach?).

In some implementations, the solicitation operation 7-302 may include an operation 7-442 for soliciting data indicating an ingestion by the user of a medicine as depicted in FIG. 7-4e. For instance, the objective occurrence data solicitation module 7-101* of the computing device 7-10 or the mobile device 7-30 soliciting (e.g., via a network interface 7-120* or via a user interface 7-122*) data indicating an ingestion by the user 7-20* of a medicine (e.g., what type of medicine was ingested on Wednesday morning?).

In some implementations, the solicitation operation 7-302 may include an operation 7-443 for soliciting data indicating an ingestion by the user of a food item as depicted in FIG. 7-4e. For instance, the objective occurrence data solicitation module 7-101* of the computing device 7-10 or the mobile device 7-30 soliciting (e.g., via a network interface 7-120* or via a user interface 7-122*) data indicating an ingestion by the user 7-20* of a food item (e.g., what did the user 7-20* eat for lunch?).

In some implementations, the solicitation operation 7-302 may include an operation 7-444 for soliciting data indicating an ingestion by the user of a nutraceutical as depicted in FIG. 7-4e. For instance, the objective occurrence data solicitation module 7-101* of the computing device 7-10 or the mobile device 7-30 soliciting (e.g., via a network interface 7-120* or via a user interface 7-122*) data indicating an ingestion by the user 7-20* of a nutraceutical (e.g., what type of nutraceutical did the user 7-20* eat on Tuesday?).

In some implementations, the solicitation operation 7-302 may include an operation 7-445 for soliciting data indicating an exercise routine executed by the user as depicted in FIG. 7-4e. For instance, the objective occurrence data solicitation module 7-101* of the computing device 7-10 or the mobile device 7-30 soliciting (e.g., via a network interface 7-120* or via a user interface 7-122*) data indicating an exercise routine executed by the user 7-20* (e.g., what type of exercise did the user 7-20* do today?).

In some implementations, the solicitation operation 7-302 may include an operation 7-446 for soliciting data indicating a social activity executed by the user as depicted in FIG. 7-4f. For instance, the objective occurrence data solicitation module 7-101* of the computing device 7-10 or the mobile device 7-30 soliciting (e.g., via a network interface 7-120* or via a user interface 7-122*) data indicating a social activity executed by the user 7-20*. For example, asking the user 7-20* or a third party (e.g., another user) whether the user 7-20* went with friends to a nightclub.

In some implementations, the solicitation operation 7-302 may include an operation 7-447 for soliciting data indicating an activity performed by one or more third parties as depicted in FIG. 7-4f. For instance, the objective occurrence data solicitation module 7-101* of the computing device 7-10 or the mobile device 7-30 soliciting (e.g., via a network interface 7-120* or via a user interface 7-122*) data indicating an activity performed by one or more third parties (e.g., boss going on vacation). For example, asking the user 7-20* or a third party (e.g., another user) whether the user 7-20* went on a vacation.

In some implementations, the solicitation operation 7-302 may include an operation 7-448 for soliciting data indicating one or more physical characteristics of the user as depicted in FIG. 7-4f. For instance, the objective occurrence data solicitation module 7-101* of the computing device 7-10 or the mobile device 7-30 soliciting (e.g., via a network interface 7-120* or via a user interface 7-122*) data indicating one or more physical characteristics (e.g., blood pressure) of the user 7-20*. For example, requesting the user 7-20*, a third party source 7-50 (e.g., a physician), or a sensor 7-35 to provide data indicating blood pressure of the user 7-20*.

In some implementations, the solicitation operation 7-302 may include an operation 7-449 for soliciting data indicating a resting, a learning, or a recreational activity by the user as depicted in FIG. 7-4f. For instance, the objective occurrence data solicitation module 7-101* of the computing device 7-10 or the mobile device 7-30 soliciting (e.g., via a network interface 7-120* or via a user interface 7-122*) data indicating a resting (e.g., sleeping), a learning (e.g., attending a class or reading a book), or a recreational activity (e.g., playing golf or fishing) by the user 7-20*.

In some implementations, the solicitation operation 7-302 may include an operation 7-450 for soliciting data indicating occurrence of one or more external events as depicted in FIG. 7-4f. For instance, the objective occurrence data solicitation module 7-101* of the computing device 7-10 or the mobile device 7-30 soliciting (e.g., via a network interface 7-120* or via a user interface 7-122*) data indicating occurrence of one or more external events (e.g., poor weather or poor stock market performance). For example requesting the user 7-20* or one or more third party sources 7-50 such as content providers to provide indications of the local weather or performance of the stock market.

In some implementations, the solicitation operation 7-302 may include an operation 7-451 for soliciting data indicating one or more locations of the user as depicted in FIG. 7-4f. For instance, the objective occurrence data solicitation module 7-101* of the computing device 7-10 or the mobile device 7-30 soliciting (e.g., via a network interface 7-120* or via a user interface 7-122*) data indicating one or more locations of the user 7-20*. For example requesting the user 7-20* or a sensor 7-35 such as a GPS to provide one or more locations of the user 7-20*.

In some implementations, the solicitation operation 7-302 may include an operation 7-452 for soliciting data indicating incidence of at least one objective occurrence that occurred during a specified point in time as depicted in FIG. 7-4f. For instance, the objective occurrence data solicitation module 7-101* of the computing device 7-10 or the mobile device 7-30 soliciting (e.g., via a network interface 7-120* or via a user interface 7-122*) data indicating incidence of at least one objective occurrence that occurred during a specified point in time (e.g., asking what the user 7-20* ate at noon).

In some implementations, the solicitation operation 7-302 may include an operation 7-453 for soliciting data indicating incidence of at least one objective occurrence that occurred during a specified time interval as depicted in FIG. 7-4f. For instance, the objective occurrence data solicitation module 7-101* of the computing device 7-10 or the mobile device 7-30 soliciting (e.g., via a network interface 7-120* or via a user interface 7-122*) data indicating incidence of at least one objective occurrence 7-71* that occurred during a specified time interval (e.g., asking whether the user 7-20* consumed any medication between 8 PM and midnight).

In various implementations, the solicitation operation 7-302 of FIG. 7-3 may include operations that may be particularly performed by the computing device 7-10. For example, in some implementations, the solicitation operation 7-302 may include an operation 7-454 for soliciting the data indicating incidence of at least one objective occurrence based, at least in part, on referencing the hypothesis as depicted in FIG. 7-4g. For instance, the objective occurrence data solicitation module 7-101 of the computing device 7-10 soliciting the data indicating incidence of at least one objective occurrence 7-71* based, at least in part, on the hypothesis referencing module 7-220 referencing the hypothesis 7-77.

Operation 7-454, in various implementations, may further include one or more additional operations. For example, in some implementations, operation 7-454 may include an operation 7-455 for soliciting the data indicating incidence of at least one objective occurrence based, at least in part, on referencing a hypothesis that identifies one or more temporal relationships between the one or more objective occurrences and the one or more subjective user states as depicted in FIG. 7-4g. For instance, the objective occurrence data solicitation module 7-101 of the computing device 7-10 soliciting the data indicating incidence of at least one objective occurrence 7-71* based, at least in part, on the hypothesis referencing module 7-220 referencing a hypothesis 7-77 that identifies one or more temporal relationships between the one or more objective occurrences and the one or more subjective user states. For example, the hypothesis 7-77 may indicate that a person may feel more alert after exercising vigorously for one hour.

In some cases, operation 7-455 may further include an operation 7-456 for soliciting the data indicating incidence of at least one objective occurrence based, at least in part, on referencing a hypothesis that identifies one or more time sequential relationships between the at least one subjective user state and the one or more objective occurrences as depicted in FIG. 7-4g. For instance, the objective occurrence data solicitation module 7-101 of the computing device 7-10 soliciting the data indicating incidence of at least one objective occurrence 7-71* based, at least in part, on the hypothesis referencing module 7-220 referencing a hypothesis 7-77 that identifies one or more time sequential relationships between the at least one subjective user state and the one or more objective occurrences. For example, the hypothesis 7-77 may indicate that a person may develop a stomach ache two hours after eating a hot fudge sundae.

In some implementations, operation 7-454 may include an operation 7-457 for soliciting the data indicating incidence of at least one objective occurrence based, at least in part, on referencing a hypothesis that identifies a relationship between at least an ingestion of a medicine and the one or more subjective user states as depicted in FIG. 7-4g. For instance, the objective occurrence data solicitation module 7-101 of the computing device 7-10 soliciting the data indicating incidence of at least one objective occurrence 7-71* based, at least in part, on the hypothesis referencing module 7-220 referencing a hypothesis 7-77 that identifies a relationship between at least an ingestion of a medicine (e.g., aspirin) and the one or more subjective user states (e.g., pain relief).

In some implementations, operation 7-454 may include an operation 7-458 for soliciting the data indicating incidence of at least one objective occurrence based, at least in part, on referencing a hypothesis that identifies a relationship between at least an ingestion of a food item and the one or more subjective user states as depicted in FIG. 7-4g. For instance, the objective occurrence data solicitation module 7-101 of the computing device 7-10 soliciting the data indicating incidence of at least one objective occurrence 7-71* based, at least in part, on the hypothesis referencing module 7-220 referencing a hypothesis 7-77 that identifies a relationship between at least an ingestion of a food item (e.g., papaya) and the one or more subjective user states (e.g., bowel movement).

In some implementations, operation 7-454 may include an operation 7-459 for soliciting the data indicating incidence of at least one objective occurrence based, at least in part, on referencing a hypothesis that identifies a relationship between at least an ingestion of a nutraceutical and the one or more subjective user states as depicted in FIG. 7-4g. For instance, the objective occurrence data solicitation module 7-101 of the computing device 7-10 soliciting the data indicating incidence of at least one objective occurrence 7-71* based, at least in part, on the hypothesis referencing module 7-220 referencing a hypothesis 7-77 that identifies a relationship between at least an ingestion of a nutraceutical and the one or more subjective user states.

In some implementations, operation 7-454 may include an operation 7-460 for soliciting the data indicating incidence of at least one objective occurrence based, at least in part, on referencing a hypothesis that identifies a relationship between execution of one or more exercise routines and the one or more subjective user states as depicted in FIG. 7-4h. For instance, the objective occurrence data solicitation module 7-101 of the computing device 7-10 soliciting the data indicating incidence of at least one objective occurrence 7-71* based, at least in part, on the hypothesis referencing module 7-220 referencing a hypothesis 7-77 that identifies a relationship between execution of one or more exercise routines (e.g., playing basketball) and the one or more subjective user states (e.g., painful ankles).

In some implementations, operation 7-454 may include an operation 7-461 for soliciting the data indicating incidence of at least one subjective user state associated with the user based, at least in part, on referencing a hypothesis that identifies a relationship between execution of one or more social activities and the one or more subjective user states as depicted in FIG. 7-4h. For instance, the objective occurrence data solicitation module 7-101 of the computing device 7-10 soliciting the data indicating incidence of at least one objective occurrence 7-71* based, at least in part, on the hypothesis referencing module 7-220 referencing a hypothesis 7-77 that identifies a relationship between execution of one or more social activities (e.g., playing with offspring) and the one or more subjective user states (e.g., happiness).

In some implementations, operation 7-454 may include an operation 7-462 for soliciting the data indicating incidence of at least one objective occurrence based, at least in part, on referencing a hypothesis that identifies a relationship between one or more activities executed by a third party and the one or more subjective user states as depicted in FIG. 7-4h. For instance, the objective occurrence data solicitation module 7-101 of the computing device 7-10 soliciting the data indicating incidence of at least one objective occurrence 7-71* based, at least in part, on the hypothesis referencing module 7-220 referencing a hypothesis 7-77 that identifies a relationship between one or more activities executed by a third party (in-laws visiting) and the one or more subjective user states (e.g., tension).

In some implementations, operation 7-454 may include an operation 7-463 for soliciting the data indicating incidence of at least one objective occurrence based, at least in part, on referencing a hypothesis that identifies a relationship between one or more physical characteristics of the user and the one or more subjective user states as depicted in FIG. 7-4h. For instance, the objective occurrence data solicitation module 7-101 of the computing device 7-10 soliciting the data indicating incidence of at least one objective occurrence 7-71* based, at least in part, on the hypothesis referencing module 7-220 referencing a hypothesis 7-77 that identifies a relationship between one or more physical characteristics (e.g., low blood sugar level) of the user 7-20* and the one or more subjective user states (e.g., lack of alertness).

In some implementations, operation 7-454 may include an operation 7-464 for soliciting the data indicating incidence of at least one objective occurrence based, at least in part, on referencing a hypothesis that identifies a relationship between a resting, a learning, or a recreational activity performed by the user and the one or more subjective user states as depicted in FIG. 7-4h. For instance, the objective occurrence data solicitation module 7-101 of the computing device 7-10 soliciting the data indicating incidence of at least one objective occurrence 7-71* based, at least in part, on the hypothesis referencing module 7-220 referencing a hypothesis 7-77 that identifies a relationship between a resting, a learning, or a recreational activity performed by the user 7-20* and the one or more subjective user states.

In some implementations, operation 7-454 may include an operation 7-465 for soliciting the data indicating incidence of at least one objective occurrence based, at least in part, on referencing a hypothesis that identifies a relationship between one or more external activities and the one or more subjective user states as depicted in FIG. 7-4h. For instance, the objective occurrence data solicitation module 7-101 of the computing device 7-10 soliciting the data indicating incidence of at least one objective occurrence 7-71* based, at least in part, on the hypothesis referencing module 7-220 referencing a hypothesis 7-77 that identifies a relationship between one or more external activities (e.g., poor performance of a sports team) and the one or more subjective user states (e.g., depression).

In some implementations, operation 7-454 may include an operation 7-466 for soliciting the data indicating incidence of at least one objective occurrence based, at least in part, on referencing a hypothesis that identifies a relationship between one or more locations of the user and the one or more subjective user states as depicted in FIG. 7-4i. For instance, the objective occurrence data solicitation module 7-101 of the computing device 7-10 soliciting the data indicating incidence of at least one objective occurrence 7-71* based, at least in part, on the hypothesis referencing module 7-220 referencing a hypothesis 7-77 that identifies a relationship between one or more locations (e.g., Hawaii) of the user 7-20* and the one or more subjective user states (e.g., relaxation).

In some implementations, operation 7-454 may include an operation 7-467 for soliciting the data indicating incidence of at least one objective occurrence based, at least in part, on referencing a hypothesis that links the at least one subjective user state with one or more historical objective occurrences as depicted in FIG. 7-4i. For instance, the objective occurrence data solicitation module 7-101 of the computing device 7-10 soliciting the data indicating incidence of at least one objective occurrence 7-71* based, at least in part, on the hypothesis referencing module 7-220 referencing a hypothesis 7-77 that links the at least one subjective user state (e.g., hangover) with one or more historical objective occurrences (e.g., alcohol consumption).

In various implementations, the solicitation operation 7-302 of FIG. 7-3 may include operations that may be particularly suited to be executed by the mobile device 7-30 of FIG. 7-1a rather than by, for example, the computing device 7-10 of FIG. 7-1b. For instance, in some implementations the solicitation operation 7-302 of FIG. 7-3 may include an operation 7-468 for soliciting the data indicating incidence of at least one objective occurrence in response to a reception of a request to solicit the data indicating incidence of at least one objective occurrence, the request to solicit being remotely generated based, at least in part, on the hypothesis as depicted in FIG. 7-4i. For instance, the objective occurrence data solicitation module 7-101′ of the mobile device 7-30 soliciting the data indicating incidence of at least one objective occurrence 7-71* in response to the request to solicit reception module 7-270 receiving a request to solicit the data indicating incidence of at least one objective occurrence 7-71*, the request to solicit being remotely generated (e.g., remotely generated by the computing device 7-10) based, at least in part, on the hypothesis 7-77. In various alternative implementations, the objective occurrence data solicitation module 7-101′ of the mobile device 7-30 may solicit the data indicating incidence of at least one objective occurrence 7-71* from a user 7-20a, from one or more sensors 7-35, or from one or more third party sources 7-50.

Operation 7-468, in turn, may further include one or more additional operations. For example, in some implementations, operation 7-468 may include an operation 7-469 for soliciting the data indicating incidence of at least one objective occurrence in response to a reception of a request to solicit the data indicating incidence of at least one objective occurrence, the request to solicit being remotely generated based, at least in part, on the hypothesis and in response to the incidence of the at least one subjective user state associated with the user as depicted in FIG. 7-4i. For instance, the objective occurrence data solicitation module 7-101′ of the mobile device 7-30 soliciting the data indicating incidence of at least one objective occurrence 7-71* in response to the request to solicit reception module 7-270 receiving a request to solicit the data indicating incidence of at least one objective occurrence 7-71*, the request to solicit being remotely generated based, at least in part, on the hypothesis 7-77 (e.g., a hypothesis linking upset stomach to ingestion of Mexican cuisine) and in response to the incidence of the at least one subjective user state (upset stomach) associated with the user 7-20a. In some implementations, such an incidence may have been initially reported by the user 7-20a via, for example, user interface 7-122′.

In some implementations, operation 7-468 may include an operation 7-470 for receiving the request to solicit the data indicating incidence of at least one objective occurrence via at least one of a wireless network or a wired network as depicted by FIG. 7-4i. For instance, the request to solicit reception module 7-270 of the mobile device 7-30 receiving the request to solicit the data indicating incidence of at least one objective occurrence 7-71* via at least one of a wireless network or a wired network 7-40.

Operation 7-470, in turn, may include an operation 7-471 for receiving the request to solicit the data indicating incidence of at least one objective occurrence from a network server as depicted by FIG. 7-4i. For instance, the request to solicit reception module 7-270 of the mobile device 7-30 receiving the request to solicit the data indicating incidence of at least one objective occurrence 7-71* from a network server (e.g., computing device 7-10).

In various implementations, the solicitation operation 7-302 of FIG. 7-3 may include an operation 7-472 for soliciting the data indicating incidence of at least one objective occurrence in response, at least in part, to receiving data indicating incidence of the at least one subjective user state associated with the user as depicted in FIG. 7-4j. For instance, the objective occurrence data solicitation module 7-101* of the computing device 7-10 or the mobile device 7-30 soliciting the data indicating incidence of at least one objective occurrence 7-71* in response, at least in part, to the subjective user state data reception module 7-224* receiving (e.g., via the network interface 7-120* or via the user interface 7-122*) data indicating incidence of the at least one subjective user state 7-61* associated with the user 7-20*.

In some implementations, operation 7-472 may further include an operation 7-473 for soliciting the data indicating incidence of at least one objective occurrence in response, at least in part, to receiving data indicating incidence of the at least one subjective user state associated with the user via a user interface as depicted in FIG. 7-4j. For instance, the objective occurrence data solicitation module 7-101* of the computing device 7-10 or the mobile device 7-30 soliciting the data indicating incidence of at least one objective occurrence 7-71* in response, at least in part, to the subjective user state data reception module 7-224* receiving data indicating incidence of the at least one subjective user state 7-61* associated with the user 7-20* via a user interface 7-122*.

In some implementations, operation 7-472 may include an operation 7-474 for soliciting the data indicating incidence of at least one objective occurrence in response, at least in part, to receiving data indicating incidence of the at least one subjective user state associated with the user via a network interface as depicted in FIG. 7-4j. For instance, the objective occurrence data solicitation module 7-101 of the computing device 7-10 soliciting the data indicating incidence of at least one objective occurrence 7-71* in response, at least in part, to the subjective user state data reception module 7-224 receiving data indicating incidence of the at least one subjective user state 7-61a associated with the user 7-20a via a network interface 7-120.

In some implementations, operation 7-472 may include an operation 7-475 for soliciting the data indicating incidence of at least one objective occurrence in response, at least in part, to receiving data indicating incidence of the at least one subjective user state associated with the user via one or more blog entries as depicted in FIG. 7-4j. For instance, the objective occurrence data solicitation module 7-101 of the computing device 7-10 soliciting the data indicating incidence of at least one objective occurrence 7-71* in response, at least in part, to receiving data indicating incidence of the at least one subjective user state 7-61a associated with the user 7-20a via one or more blog entries.

In some implementations, operation 7-472 may include an operation 7-476 for soliciting the data indicating incidence of at least one objective occurrence in response, at least in part, to receiving data indicating incidence of the at least one subjective user state associated with the user via one or more status reports as depicted in FIG. 7-4j. For instance, the objective occurrence data solicitation module 7-101 of the computing device 7-10 soliciting the data indicating incidence of at least one objective occurrence 7-71* in response, at least in part, to receiving data indicating incidence of the at least one subjective user state 7-61a associated with the user 7-20a via one or more status reports.

In some implementations, operation 7-472 may include an operation 7-477 for soliciting the data indicating incidence of at least one objective occurrence in response, at least in part, to receiving data indicating incidence of the at least one subjective user state associated with the user via one or more electronic messages as depicted in FIG. 7-4j. For instance, the objective occurrence data solicitation module 7-101 of the computing device 7-10 soliciting the data indicating incidence of at least one objective occurrence 7-71* in response, at least in part, to receiving data indicating incidence of the at least one subjective user state 7-61a associated with the user 7-20a via one or more electronic messages.

In some implementations, operation 7-472 may include an operation 7-478 for soliciting the data indicating incidence of at least one objective occurrence in response, at least in part, to receiving data indicating incidence of the at least one subjective user state associated with the user from the user as depicted in FIG. 7-4j. For instance, the objective occurrence data solicitation module 7-101* of the computing device 7-10 or the mobile device 7-30 soliciting the data indicating incidence of at least one objective occurrence 7-71* in response, at least in part, to receiving data indicating incidence of the at least one subjective user state 7-61* associated with the user 7-20* from the user 7-20*.

Referring back to FIG. 7-3, the objective occurrence data acquisition operation 7-304 may include one or more additional operations in various alternative implementations. For example, in various implementations, the objective occurrence data acquisition operation 7-304 may include a reception operation 7-502 for receiving the objective occurrence data including the data indicating incidence of at least one objective occurrence as depicted in FIG. 7-5a. For instance, the objective occurrence data reception module 7-234* of the computing device 7-10 or the mobile device 7-30 receiving (e.g., via the user interface 7-122* or via at least one of a wireless network or wired network 7-40) the objective occurrence data 7-70* including the data indicating incidence of at least one objective occurrence 7-71*.

In various alternative implementations, the reception module 7-502 may include one or more additional operations. For example, in some implementations, the reception operation 7-502 may include an operation 7-504 for receiving the objective occurrence data including the data indicating incidence of at least one objective occurrence via a user interface as depicted in FIG. 7-5a. For instance, the user interface data reception module 7-235* of the computing device 7-10 or the mobile device 7-30 receiving the objective occurrence data 7-70* including the data indicating incidence of at least one objective occurrence 7-71* via a user interface 7-122* (e.g., a microphone, a keypad, a touchscreen, and so forth).

In some implementations, the reception operation 7-502 may include an operation 7-506 for receiving the objective occurrence data including the data indicating incidence of at least one objective occurrence from at least one of a wireless network or a wired network as depicted in FIG. 7-5a. For instance, the network interface data reception module 7-236* of the computing device 7-10 or the mobile device 7-30 receiving the objective occurrence data 7-70* including the data indicating incidence of at least one objective occurrence 7-71* from at least one of a wireless network or a wired network 7-40.

In some implementations, the reception operation 7-502 may include an operation 7-510 for receiving the objective occurrence data including the data indicating incidence of at least one objective occurrence via one or more blog entries as depicted in FIG. 7-5a. For instance, the network interface data reception module 7-236* of the computing device 7-10 or the mobile device 7-30 receiving the objective occurrence data 7-70* including the data indicating incidence of at least one objective occurrence 7-71* via one or more blog entries (e.g., microblog entries).

In some implementations, the reception operation 7-502 may include an operation 7-512 for receiving the objective occurrence data including the data indicating incidence of at least one objective occurrence via one or more status reports as depicted in FIG. 7-5a. For instance, the network interface data reception module 7-236* of the computing device 7-10 or the mobile device 7-30 receiving the objective occurrence data 7-70* including the data indicating incidence of at least one objective occurrence 7-71* via one or more status reports (e.g., social networking status reports).

In some implementations, the reception operation 7-502 may include an operation 7-514 for receiving the objective occurrence data including the data indicating incidence of at least one objective occurrence via one or more electronic messages as depicted in FIG. 7-5a. For instance, the network interface data reception module 7-236* of the computing device 7-10 or the mobile device 7-30 receiving the objective occurrence data 7-70* including the data indicating incidence of at least one objective occurrence 7-71* via one or more electronic messages (e.g., text messages, email messages, IM messages, or other types of messages).

In some implementations, the reception operation 7-502 may include an operation 7-516 for receiving a selection made by the user, the selection being a selection of an objective occurrence from a plurality of indicated alternative objective occurrences as depicted in FIG. 7-5b. For instance, the objective occurrence data reception module 7-234* of the computing device 7-10 or the mobile device 7-30 receiving a selection made by the user 7-20*, the selection being a selection of an objective occurrence from a plurality of indicated alternative objective occurrences (e.g., as indicated via a user interface 7-122*).

In some implementations, the reception operation 7-502 may include an operation 7-518 for receiving the objective occurrence data including the data indicating incidence of at least one objective occurrence from the user as depicted in FIG. 7-5b. For instance, the objective occurrence data reception module 7-234* of the computing device 7-10 or the mobile device 7-30 receiving the objective occurrence data 7-70c including the data indicating incidence of at least one objective occurrence 7-71c from the user 7-20*.

In some implementations, the reception operation 7-502 may include an operation 7-520 for receiving the objective occurrence data including the data indicating incidence of at least one objective occurrence from one or more third party sources as depicted in FIG. 7-5b. For instance, the objective occurrence data reception module 7-234* of the computing device 7-10 or the mobile device 7-30 receiving the objective occurrence data 7-70a including the data indicating incidence of at least one objective occurrence 7-71a from one or more third party sources 7-50 (e.g., other users, content providers, health care providers, health fitness providers, social organizations, business, and so forth).

In some implementations, the reception operation 7-502 may include an operation 7-522 for receiving the objective occurrence data including the data indicating incidence of at least one objective occurrence from one or more remote devices as depicted in FIG. 7-5b. For instance, the objective occurrence data reception module 7-234* of the computing device 7-10 or the mobile device 7-30 receiving the objective occurrence data 7-70b including the data indicating incidence of at least one objective occurrence 7-71b from one or more remote devices (e.g., sensors 7-35 or remote network servers).

In some implementations, the objective occurrence data acquisition operation 7-304 of FIG. 7-3 may include an operation 7-524 for acquiring data indicating an ingestion by the user of a medicine as depicted in FIG. 7-5c. For instance, the objective occurrence data acquisition module 7-104* of the computing device 7-10 or the mobile device 7-30 acquiring (e.g., receiving, retrieving, or accessing) data indicating an ingestion by the user 7-20* of a medicine (e.g., a dosage of a beta blocker).

In some implementations, the objective occurrence data acquisition operation 7-304 may include an operation 7-526 for acquiring data indicating an ingestion by the user of a food item as depicted in FIG. 7-5c. For instance, the objective occurrence data acquisition module 7-104* of the computing device 7-10 or the mobile device 7-30 acquiring data indicating an ingestion by the user 7-20* of a food item (e.g., a fruit).

In some implementations, the objective occurrence data acquisition operation 7-304 may include an operation 7-528 for acquiring data indicating an ingestion by the user of a nutraceutical as depicted in FIG. 7-5c. For instance, the objective occurrence data acquisition module 7-104* of the computing device 7-10 or the mobile device 7-30 acquiring data indicating an ingestion by the user 7-20* of a nutraceutical (e.g. broccoli).

In some implementations, the objective occurrence data acquisition operation 7-304 may include an operation 7-530 for acquiring data indicating an exercise routine executed by the user as depicted in FIG. 7-5c. For instance, the objective occurrence data acquisition module 7-104* of the computing device 7-10 or the mobile device 7-30 acquiring data indicating an exercise routine (e.g., exercising on an exercise machine such as a treadmill) executed by the user 7-20*.

In some implementations, the objective occurrence data acquisition operation 7-304 may include an operation 7-532 for acquiring data indicating a social activity executed by the user as depicted in FIG. 7-5c. For instance, the objective occurrence data acquisition module 7-104* of the computing device 7-10 or the mobile device 7-30 acquiring data indicating a social activity (e.g., hiking or skiing with friends, dates, dinners, and so forth) executed by the user 7-20*.

In some implementations, the objective occurrence data acquisition operation 7-304 may include an operation 7-534 for acquiring data indicating an activity performed by one or more third parties as depicted in FIG. 7-5c. For instance, the objective occurrence data acquisition module 7-104* of the computing device 7-10 or the mobile device 7-30 acquiring data indicating an activity performed by one or more third parties (e.g., spouse leaving home to visit relatives).

In some implementations, the objective occurrence data acquisition operation 7-304 may include an operation 7-536 for acquiring data indicating one or more physical characteristics of the user as depicted in FIG. 7-5c. For instance, the objective occurrence data acquisition module 7-104* of the computing device 7-10 or the mobile device 7-30 acquiring data indicating one or more physical characteristics (e.g., blood sugar or blood pressure level) of the user 7-20*.

In some implementations, the objective occurrence data acquisition operation 7-304 may include an operation 7-538 for acquiring data indicating a resting, a learning, or a recreational activity by the user as depicted in FIG. 7-5c. For instance, the objective occurrence data acquisition module 7-104* of the computing device 7-10 or the mobile device 7-30 acquiring data indicating a resting (e.g., napping), a learning (e.g., attending a lecture), or a recreational activity (e.g., boating) by the user 7-20*.

In some implementations, the objective occurrence data acquisition operation 7-304 may include an operation 7-540 for acquiring data indicating occurrence of one or more external events as depicted in FIG. 7-5c. For instance, the objective occurrence data acquisition module 7-104* of the computing device 7-10 or the mobile device 7-30 acquiring data indicating occurrence of one or more external events (e.g., sub-freezing weather).

In some implementations, the objective occurrence data acquisition operation 7-304 may include an operation 7-542 for acquiring data indicating one or more locations of the user as depicted in FIG. 7-5d. For instance, the objective occurrence data acquisition module 7-104* of the computing device 7-10 or the mobile device 7-30 acquiring data indicating one or more locations of the user 7-20*.

In some implementations, the objective occurrence data acquisition operation 7-304 may include an operation 7-544 for acquiring data indicating incidence of at least one objective occurrence that occurred during a specified point in time as depicted in FIG. 7-5d. For instance, the objective occurrence data acquisition module 7-104* of the computing device 7-10 or the mobile device 7-30 acquiring data indicating incidence of at least one objective occurrence 7-71* that occurred during a specified point in time (e.g., as specified through a user interface 7-122*).

In some implementations, the objective occurrence data acquisition operation 7-304 may include an operation 7-546 for acquiring data indicating incidence of at least one objective occurrence that occurred during a specified time interval as depicted in FIG. 7-5d. For instance, the objective occurrence data acquisition module 7-104* of the computing device 7-10 or the mobile device 7-30 acquiring data indicating incidence of at least one objective occurrence that occurred during a specified time interval (e.g., as specified through a user interface 7-122*).

In some implementations, the objective occurrence data acquisition operation 7-304 may include an operation 7-548 for acquiring data indicating incidence of at least one objective occurrence at a server as depicted in FIG. 7-5d. For instance, when the computing device 7-10 is a server and acquires the data indicating incidence of at least one objective occurrence 7-71*.

In some implementations, the objective occurrence data acquisition operation 7-304 may include an operation 7-550 for acquiring data indicating incidence of at least one objective occurrence at a handheld device as depicted in FIG. 7-5d. For instance, when the computing device 7-10 is a standalone device and is a handheld device or when the mobile device 7-30 is a handheld device and acquires the data indicating incidence of at least one objective occurrence 7-71*.

In some implementations, the objective occurrence data acquisition operation 7-304 may include an operation 7-552 for acquiring data indicating incidence of at least one objective occurrence at a peer-to-peer network component device as depicted in FIG. 7-5d. For instance, when the computing device 7-10 is a standalone device and is a peer-to-peer network component device or the mobile device 7-30 is a peer-to-peer network component device and acquires the data indicating incidence of at least one objective occurrence 7-71*.

In some implementations, the objective occurrence data acquisition operation 7-304 may include an operation 7-554 for acquiring data indicating incidence of at least one objective occurrence via a Web 2.0 construct as depicted in FIG. 7-5d. For instance, when the computing device 7-10 or the mobile device 7-30 is running a web 2.0 application 7-268 and acquires the data indicating incidence of at least one objective occurrence 7-71*.

Referring to FIG. 7-6 illustrating another operational flow 7-600 in accordance with various embodiments. Operational flow 7-600 includes certain operations that mirror the operations included in operational flow 7-300 of FIG. 7-3. For example, operational flow 7-600 includes an objective occurrence data solicitation operation 7-602 and an objective occurrence data acquisition operation 7-604 that correspond to and mirror the objective occurrence data solicitation operation 7-302 and the objective occurrence data acquisition operation 7-304, respectively, of FIG. 7-3.

In addition, and unlike operation 7-300 of FIG. 7-3, operational flow 7-600 may additionally include a subjective user state data acquisition operation 7-606 for acquiring subjective user state data including data indicating incidence of the at least one subjective user state associated with the user as depicted in FIG. 7-6. For instance, the subjective user state data acquisition module 7-102* of the computing device 7-10 or the mobile device 7-30 acquiring (e.g., receiving, gathering, or retrieving via the network interface 7-120* or via the user interface 7-122*) subjective user state data 7-60* including data indicating incidence of the at least one subjective user state 7-61* associated with the user 7-20*.

In various alternative implementations, the subjective user state data acquisition operation 7-606 may include one or more additional operations. For example, in some implementations, the subjective user state data acquisition operation 7-606 may include a reception operation 7-702 for receiving the subjective user state data as depicted in FIG. 7-7a. For instance, the subjective user state data reception module 7-224* of the computing device 7-10 or the mobile device 7-30 receiving the subjective user state data 7-60*.

The reception operation 7-702, in turn, may include one or more additional operations in various alternative implementations. For example, in some implementations, the reception operation 7-702 may include an operation 7-704 for receiving the subjective user state data via a user interface as depicted in FIG. 7-7a. For instance, the user interface reception module 7-226* of the computing device 7-10 (e.g., when the computing device 7-10 is a standalone device) or the mobile device 7-30 receiving the subjective user state data 7-60* via a user interface 7-122* (e.g., a keyboard, a mouse, a touchscreen, a microphone, an image capturing device such as a digital camera, and/or other interface devices).

In some implementations, the reception operation 7-702 may include an operation 7-706 for receiving the subjective user state data from at least one of a wireless network or a wired network as depicted in FIG. 7-7a. For instance, the network interface reception module 7-227 of the computing device 7-10 (e.g., when the computing device 7-10 is a server) receiving the subjective user state data 7-60* from at least one of a wireless network or a wired network 7-40.

In some implementations, the reception operation 7-702 may include an operation 7-708 for receiving the subjective user state data via one or more blog entries as depicted in FIG. 7-7a. For instance, the network interface reception module 7-227 of the computing device 7-10 (e.g., when the computing device 7-10 is a server) receiving the subjective user state data 7-60* via one or more blog entries (e.g., microblog entries).

In some implementations, the reception operation 7-702 may include an operation 7-710 for receiving the subjective user state data via one or more status reports as depicted in FIG. 7-7a. For instance, the network interface reception module 7-227 of the computing device 7-10 (e.g., when the computing device 7-10 is a server) receiving the subjective user state data 7-60* via one or more status reports (e.g., social networking status reports).

In some implementations, the reception operation 7-702 may include an operation 7-712 for receiving the subjective user state data via one or more electronic messages as depicted in FIG. 7-7a. For instance, the network interface reception module 7-227 of the computing device 7-10 (e.g., when the computing device 7-10 is a server) receiving the subjective user state data 7-60* via one or more electronic messages (e.g., text message, email message, audio or text message, IM message, or other types of electronic messages).

In some implementations, the reception operation 7-702 may include an operation 7-714 for receiving the subjective user state data from the user as depicted in FIG. 7-7a. For instance, the subjective user state data reception module 7-224* of the computing device 7-10 or the mobile device 7-30 receiving the subjective user state data 7-60* from the user 7-20*.

Operation 7-714, in turn, may further include an operation 7-716 for receiving the subjective user state data from the user via one or more remote network devices as depicted in FIG. 7-7a. For instance, the network interface reception module 7-227 of the computing device 7-10 (e.g., when the computing device 7-10 is a server) receiving the subjective user state data 7-60a from the user 7-20a via one or more remote network devices (e.g., mobile device 7-30 or other devices such as other network servers).

In some implementations, the reception operation 7-702 may include an operation 7-718 for receiving a selection made by the user, the selection being a selection of a subjective user state from a plurality of indicated alternative subjective user states as depicted in FIG. 7-7a. For instance, the subjective user state data reception module 7-224* of the computing device 7-10 or the mobile device 7-30 receiving (e.g., receiving from at least one of a wireless network or a wired network 7-40 or via a user interface 7-122*) a selection made by the user 7-20*, the selection being a selection of a subjective user state from a plurality of indicated alternative subjective user states (e.g., as indicated through a user interface 7-122*).

In various implementations, the subjective user state data acquisition operation 7-606 of FIG. 7-6 may include an operation 7-720 for acquiring data indicating at least one subjective mental state associated with the user as depicted in FIG. 7-7a. For instance, the subjective user state data acquisition module 7-102* of the computing device 7-10 or the mobile device 7-30 acquiring (e.g., receiving, retrieving, or accessing) data indicating at least one subjective mental state (e.g., happiness, sadness, depression, anger, frustration, elation, fear, alertness, sleepiness, envy, and so forth) associated with the user 7-20*.

In some implementations, the subjective user state data acquisition operation 7-606 may include an operation 7-722 for acquiring data indicating at least one subjective physical state associated with the user as depicted in FIG. 7-7a. For instance, the subjective user state data acquisition module 7-102* of the computing device 7-10 or the mobile device 7-30 acquiring (e.g., receiving, retrieving, or accessing) data indicating at least one subjective physical state (e.g., pain, blurring vision, hearing loss, upset stomach, physical exhaustion, and so forth) associated with the user 7-20*.

In some implementations, the subjective user state data acquisition operation 7-606 may include an operation 7-724 for acquiring data indicating at least one subjective overall state associated with the user as depicted in FIG. 7-7b. For instance, the subjective user state data acquisition module 7-102* of the computing device 7-10 or the mobile device 7-30 acquiring (e.g., receiving, retrieving, or accessing) data indicating at least one subjective overall state (e.g., good, bad, well, lousy, and so forth) associated with the user 7-20*.

In some implementations, the subjective user state data acquisition operation 7-606 may include an operation 7-726 for acquiring a time stamp associated with the incidence of the at least one subjective user state as depicted in FIG. 7-7b. For instance, the time stamp acquisition module 7-230* of the computing device 7-10 or the mobile device 7-30 acquiring (e.g., receiving or generating) a time stamp associated with the incidence of the at least one subjective user state.

In some implementations, the subjective user state data acquisition operation 7-606 may include an operation 7-728 for acquiring an indication of a time interval associated with the incidence of the at least one subjective user state as depicted in FIG. 7-7b. For instance, the time interval acquisition module 7-231* of the computing device 7-10 or the mobile device 7-30 acquiring (e.g., receiving or generating) an indication of a time interval associated with the incidence of the at least one subjective user state.

In some implementations, the subjective user state data acquisition operation 7-606 may include an operation 7-730 for acquiring the subjective user state data at a server as depicted in FIG. 7-7b. For instance, when the computing device 7-10 is a network server and is acquiring the subjective user state data 7-60a.

In some implementations, the subjective user state data acquisition operation 7-606 may include an operation 7-732 for acquiring the subjective user state data at a handheld device as depicted in FIG. 7-7b. For instance, when the computing device 7-10 is a standalone device and is a handheld device (e.g., a cellular telephone, a smartphone, an MID, an UMPC, or a convergent device such as a PDA) or the mobile device 7-30 is a handheld device, and the computing device 7-10 or the mobile device 7-30 is acquiring the subjective user state data 7-60*.

In some implementations, the subjective user state data acquisition operation 7-606 may include an operation 7-734 for acquiring the subjective user state data at a peer-to-peer network component device as depicted in FIG. 7-7b. For instance, when the computing device 7-10 or the mobile device 7-30 is a peer-to-peer network component device and the computing device 7-10 or the mobile device 7-30 is acquiring the subjective user state data 7-60*.

In some implementations, the subjective user state data acquisition operation 7-606 may include an operation 7-736 for acquiring the subjective user state data via a Web 2.0 construct as depicted in FIG. 7-7b. For instance, when the computing device 7-10 or the mobile device 7-30 acquires the subjective user state data 7-60* via a Web 2.0 construct (e.g., Web 2.0 application 7-268).

Referring now to FIG. 7-8 illustrating still another operational flow 7-800 in accordance with various embodiments. In some embodiments, operational flow 7-800 may be particularly suited to be performed by the computing device 7-10, which may be a network server or a standalone device. Operational flow 7-800 includes operations that mirror the operations included in the operational flow 7-600 of FIG. 7-6. For example, operational flow 7-800 may include an objective occurrence data solicitation operation 7-802, an objective occurrence data acquisition operation 7-804, and a subjective user state data acquisition operation 7-806 that corresponds to and mirror the objective occurrence data solicitation operation 7-602, the objective occurrence data acquisition operation 7-604, and the subjective user state data acquisition operation 7-606, respectively, of FIG. 7-6.

In addition, and unlike operational flow 7-600, operational flow 7-800 may further include a correlation operation 7-808 for correlating the subjective user state data with the objective occurrence data and a presentation operation 7-810 for presenting one or more results of the correlating of the subjective user state data with the objective occurrence data as depicted in FIG. 7-8. For instance, the correlation module 7-106 of the computing device 7-10 correlating (e.g., linking or determining a relationship between) the subjective user state data 7-60* with the objective occurrence data 7-70*. The presentation module 7-108 of the computing device 7-10 may then present (e.g., transmit via a network interface 7-120 or indicate via a user interface 7-122) one or more results of the correlation operation 7-808 performed by the correlation module 7-106.

In various alternative implementations, the correlation operation 7-808 may include one or more additional operations. For example, in some implementations, the correlation operation 7-808 may include an operation 7-902 for correlating the subjective user state data with the objective occurrence data based, at least in part, on a determination of at least one sequential pattern associated with the at least one subjective user state and the at least one objective occurrence as depicted in FIG. 7-9. For instance, the correlation module 7-106 of the computing device 7-10 correlating the subjective user state data 7-60* with the objective occurrence data 7-70* based, at least in part, on the sequential pattern determination module 7-242 determining at least one sequential pattern associated with the at least one subjective user state indicated by the subjective user state data 7-60* and the at least one objective occurrence indicated by the objective occurrence data 7-70*.

Operation 7-902, in turn, may further include one or more additional operations. For example, in some implementations, operation 7-902 may include an operation 7-904 for correlating the subjective user state data with the objective occurrence data based, at least in part, on referencing historical data as depicted in FIG. 7-9. For instance, the correlation module 7-106 of the computing device 7-10 correlating the subjective user state data 7-60* with the objective occurrence data 7-70* based, at least in part, on the historical data referencing module 7-243 referencing historical data 7-78. Examples of historical data 7-78 includes, for example, previously reported incidences of subjective user states associated with the user 7-20* and/or with other users as they relate to objective occurrences, historical sequential patterns associated with the user 7-20* or with other users, historical medical data relating to the user 7-20 and/or other users, and/or other types of historical data 7-78.

In some implementations, operation 7-904 may include an operation 7-906 for correlating the subjective user state data with the objective occurrence data based, at least in part, on a historical sequential pattern as further depicted in FIG. 7-9. For instance, the correlation module 7-106 of the computing device 7-10 correlating the subjective user state data 7-60* with the objective occurrence data 7-70* based, at least in part, on the historical data referencing module 7-243 referencing a historical sequential pattern associated with the user 7-20*, with other users, and/or with a subset of the general population.

In some implementations, operation 7-904 may include an operation 7-908 for correlating the subjective user state data with the objective occurrence data based, at least in part, on referencing historical medical data as depicted in FIG. 7-9. For instance, the correlation module 7-106 of the computing device 7-10 correlating the subjective user state data 7-60* with the objective occurrence data 7-70* based, at least in part, on the historical data referencing module 7-243 referencing historical medical data (e.g., genetic, metabolome, or proteome information or medical records of the user 7-20* or of others related to, for example, diabetes or heart disease).

In various implementations, operation 7-902 may include an operation 7-910 for comparing the at least one sequential pattern to a second sequential pattern to determine whether the at least one sequential pattern at least substantially matches with the second sequential pattern as depicted in FIG. 7-9. For instance, the sequential pattern comparison module 7-248 of the computing device 7-10 comparing the at least one sequential pattern to a second sequential pattern to determine whether the at least one sequential pattern at least substantially matches with the second sequential pattern.

Operation 7-910, in some implementations, may further include an operation 7-912 for comparing the at least one sequential pattern to a second sequential pattern related to at least a second subjective user state associated with the user and a second objective occurrence to determine whether the at least one sequential pattern at least substantially matches with the second sequential pattern as depicted in FIG. 7-9. For instance, the sequential pattern comparison module 7-248 of the computing device 7-10 comparing the at least one sequential pattern to a second sequential pattern related to at least a previously reported second subjective user state associated with the user 7-20* and a second previously reported objective occurrence to determine whether the at least one sequential pattern at least substantially matches with the second sequential pattern.

For these implementations, the comparison of the first sequential pattern to the second sequential pattern may involve making certain comparisons, For example, comparing the first subjective user state to the second subjective user state to determine at least whether they are the same or different types of subjective user states. Similarly, the first objective occurrence may be compared to the second objective occurrence to determine at least whether they are the same or different types of objective occurrences. The temporal relationship or the specific time sequencing between the incidence of the first subjective user state and the incidence of the first objective occurrence (e.g., as represented by the first sequential pattern) may then be compared to the temporal relationship or the specific time sequencing between the incidence of the second subjective user state and the incidence of the second objective occurrence (e.g., as represented by the second sequential pattern).

In some implementations, the correlation operation 7-808 of FIG. 7-8 may include an operation 7-914 for correlating the subjective user state data with the objective occurrence data at a server as depicted in FIG. 7-9. For instance, when the computing device 7-10 is a server (e.g., network server) and the correlation module 7-106 correlates the subjective user state data 7-60* with the objective occurrence data 7-70*.

In alternative implementations, the correlation operation 7-808 may include an operation 7-916 for correlating the subjective user state data with the objective occurrence data at a handheld device as depicted in FIG. 7-9. For instance, when the computing device 7-10 is a standalone device, such as a handheld device, and the correlation module 7-106 correlates the subjective user state data 7-60* with the objective occurrence data 7-70*.

In some implementations, the correlation operation 7-808 may include an operation 7-918 for correlating the subjective user state data with the objective occurrence data at a peer-to-peer network component device as depicted in FIG. 7-9. For instance, when the computing device 7-10 is a standalone device and is a peer-to-peer network component device, and the correlation module 7-106 correlates the subjective user state data 7-60* with the objective occurrence data 7-70*.

Referring back to FIG. 7-8, the presentation operation 7-810 may include one or more additional operations in various alternative implementations. For example, in some implementations, the presentation operation 7-810 may include an operation 7-1002 for indicating the one or more results of the correlating via a user interface as depicted in FIG. 7-10. For instance, when the computing device 7-10 is a standalone device such as a handheld device (e.g., cellular telephone, a smartphone, an MID, an UMPC, a convergent device, and so forth) or other mobile devices, and the user interface indication module 7-259 of the computing device 7-10 indicates the one or more results of the correlation operation performed by the correlation module 7-106 via a user interface 7-122 (e.g., display monitor or audio system including a speaker).

In some implementations, the presentation operation 7-810 may include an operation 7-1004 for transmitting the one or more results of the correlating via a network interface as depicted in FIG. 7-10. For instance, when the computing device 7-10 is a server and the network interface transmission module 7-258 of the computing device 7-10 transmits the one or more results of the correlation operation performed by the correlation module 7-106 via a network interface 7-120 (e.g., NIC).

In some implementations, the presentation operation 7-810 may include an operation 7-1006 for presenting an indication of a sequential relationship between the at least one subjective user state and the at least one objective occurrence as depicted in FIG. 7-10. For instance, the sequential relationship presentation module 7-260 of the computing device 7-10 presenting (e.g., either by transmitting via the network interface 7-120 or by indicating via the user interface 7-122) an indication of a sequential relationship between the at least one subjective user state (e.g., happy) and the at least one objective occurrence (e.g., playing with children).

In some implementations, the presentation operation 7-810 may include an operation 7-1008 for presenting a prediction of a future subjective user state resulting from a future objective occurrence associated with the user as depicted in FIG. 7-10. For instance, the prediction presentation module 7-261 of the computing device 7-10 presenting (e.g., either by transmitting via the network interface 7-120 or by indicating via the user interface 7-122) a prediction of a future subjective user state associated with the user 7-20* resulting from a future objective occurrence (e.g., “if you drink the 24 ounces of beer you ordered, you will have a hangover tomorrow”).

In some implementations, the presentation operation 7-810 may include an operation 7-1010 for presenting a prediction of a future subjective user state resulting from a past objective occurrence associated with the user as depicted in FIG. 7-10. For instance, the prediction presentation module 7-261 of the computing device 7-10 presenting (e.g., either by transmitting via the network interface 7-120 or by indicating via the user interface 7-122) a prediction of a future subjective user state associated with the user 7-20* resulting from a past objective occurrence (e.g., “you will have a stomach ache shortly because of the hot fudge sundae that you just ate”).

In some implementations, the presentation operation 7-810 may include an operation 7-1012 for presenting a past subjective user state in connection with a past objective occurrence associated with the user as depicted in FIG. 7-10. For instance, the past presentation module 7-262 of the computing device 7-10 presenting (e.g., either by transmitting via the network interface 7-120 or by indicating via the user interface 7-122) a past subjective user state associated with the user 7-20* in connection with a past objective occurrence (e.g., “reason why you had a headache this morning may be because you drank that 24 ounces of beer last night”).

In some implementations, the presentation operation 7-810 may include an operation 7-1014 for presenting a recommendation for a future action as depicted in FIG. 7-10. For instance, the recommendation module 7-263 of the computing device 7-10 presenting (e.g., either by transmitting via the network interface 7-120 or by indicating via the user interface 7-122) a recommendation for a future action (e.g., “you should buy something to calm your stomach tonight after you leave the bar tonight”).

In some implementations, operation 7-1014 may further include an operation 7-1016 for presenting a justification for the recommendation as depicted in FIG. 7-10. For instance, the justification module 7-264 of the computing device 7-10 presenting (e.g., either by transmitting via the network interface 7-120 or by indicating via the user interface 7-122) a justification for the recommendation (e.g., “you should buy something to calm your stomach tonight since you are drinking beer tonight, and the last time you drank beer, you had an upset stomach the next morning”).

In some implementations, the presentation operation 7-810 may include an operation 7-1018 for presenting the hypothesis as depicted in FIG. 7-10. For instance, the hypothesis presentation module 7-267 of the computing device 7-10 presenting (e.g., via the user interface 7-122 or via the network interface 7-120) the hypothesis 7-77 to, for example, the user 7-20* or to one or more third parties. Such an operation may be performed in some cases when the data indicating incidence of at least one objective occurrence 7-71* that was solicited is acquired and confirms or provides support for the hypothesis 7-77.

FIG. 7-11 illustrates another operational flow 7-1100 in accordance with various embodiments. In contrast to the previous operational flow 7-800, operational flow 7-1100 may be particularly suited to be performed by a mobile device 7-30 rather than by the computing device 7-10. Operational flow 7-1100 includes certain operations that may completely or substantially mirror certain operations included in the operational flow 7-800 of FIG. 7-8. For example, operational flow 7-1100 may include an objective occurrence data solicitation operation 7-1102, an objective occurrence data acquisition operation 7-1104, and a presentation operation 7-1110 that corresponds to and completely or substantially mirror the objective occurrence data solicitation operation 7-802, the objective occurrence data acquisition operation 7-804, and the presentation operation 7-810, respectively, of FIG. 7-8.

In addition, and unlike operational flow 7-800, operational flow 7-1100 may further include an objective occurrence data transmission operation 7-1106 for transmitting the acquired objective occurrence data including the data indicating incidence of at least one objective occurrence and a reception operation 7-1108 for receiving one or more results of correlation of the objective occurrence data with subjective user state data including data indicating the incidence of the at least one subjective user state associated with the user as depicted in FIG. 7-11. For example, the objective occurrence data transmission module 7-160 of the mobile device 7-30 transmitting (e.g., transmitting via at least one of the wireless network or wired network 7-40 to, for example, a network server such as computing device 7-10) the acquired objective occurrence data 7-70* including the data indicating incidence of at least one objective occurrence 7-71*. Note that the mobile device 7-30 may, itself, have originally acquired the data indicating incidence of at least one objective occurrence 7-71* from the user 7-20a, from one or more sensors 7-35, or from one or more third party sources 7-50.

The correlation results reception module 7-162 of the mobile device 7-30 may then receive (e.g., receive from the computing device 7-10) one or more results of correlation of the subjective user state data 7-60a with objective occurrence data 7-70* including data indicating the incidence of the at least one objective occurrence 7-71*.

In various alternative implementations, the objective occurrence data transmission operation 7-1106 may include one or more additional operations. For example, in some implementations, the objective occurrence data transmission operation 7-1106 may include an operation 7-1202 for transmitting the acquired objective occurrence data via at least a wireless network or a wired network as depicted in FIG. 7-12. For instance, the objective occurrence data transmission module 7-160 of the mobile device 7-30 transmitting the acquired objective occurrence data 7-70* via at least one of a wireless network or a wired network 7-40.

In some implementations, operation 7-1202 may further include an operation 7-1204 for transmitting the acquired objective occurrence data via one or more blog entries as depicted in FIG. 7-12. For instance, the objective occurrence data transmission module 7-160 of the mobile device 7-30 transmitting the acquired objective occurrence data 7-70* via one or more blog entries (e.g., microblog entries).

In some implementations, operation 7-1202 may include an operation 7-1206 for transmitting the acquired objective occurrence data via one or more status reports as depicted in FIG. 7-12. For instance, the objective occurrence data transmission module 7-160 of the mobile device 7-30 transmitting the acquired objective occurrence data 7-70* via one or more status reports (e.g., social networking status reports).

In some implementations, operation 7-1202 may include an operation 7-1208 for transmitting the acquired objective occurrence data via one or more electronic messages as depicted in FIG. 7-12. For instance, the objective occurrence data transmission module 7-160 of the mobile device 7-30 transmitting the acquired objective occurrence data 7-70* via one or more electronic messages (e.g., email message, IM messages, text messages, and so forth).

In some implementations, operation 7-1202 may include an operation 7-1210 for transmitting the acquired objective occurrence data to a network server as depicted in FIG. 7-12. For instance, the objective occurrence data transmission module 7-160 of the mobile device 7-30 transmitting the acquired objective occurrence data 7-70* to a network server (e.g., computing device 7-10).

Referring back to FIG. 7-11, the reception operation 7-1108 may include one or more additional operations in various alternative implementations. For example, in some implementations, the reception operation 7-1108 may include an operation 7-1302 for receiving an indication of a sequential relationship between the at least one subjective user state and the at least one objective occurrence as depicted in FIG. 7-13. For instance, the correlation results reception module 7-162 of the mobile device 7-30 receiving (e.g., via wireless network and/or wired network 7-40) at least an indication of a sequential relationship between the at least one subjective user state (e.g., as indicated by the data indicating incidence of at least one subjective user state 7-61a) and the at least one objective occurrence (e.g., as indicated by the data indicating incidence of at least one objective occurrence 7-71*). For example, receiving an indication that the user 7-20a felt energized after jogging for thirty minutes.

In some implementations, the reception operation 7-1108 may include an operation 7-1304 for receiving a prediction of a future subjective user state resulting from a future objective occurrence associated with the user as depicted in FIG. 7-13. For instance, the correlation results reception module 7-162 of the mobile device 7-30 receiving (e.g., via wireless network and/or wired network 7-40) at least a prediction of a future subjective user state (e.g., feeling energized) associated with the user 7-20a resulting from a future objective occurrence (e.g., jogging for 30 minutes).

In some implementations, the reception operation 7-1108 may include an operation 7-1306 for receiving a prediction of a future subjective user state resulting from a past objective occurrence associated with the user as depicted in FIG. 7-13. For instance, the correlation results reception module 7-162 of the mobile device 7-30 receiving (e.g., via wireless network and/or wired network 7-40) at least a prediction of a future subjective user state (e.g., easing of pain) associated with the user 7-20a resulting from a past objective occurrence (e.g., previous ingestion of aspirin).

In some implementations, the reception operation 7-1108 may include an operation 7-1308 for receiving a past subjective user state in connection with a past objective occurrence as depicted in FIG. 7-13. For instance, the correlation results reception module 7-162 of the mobile device 7-30 receiving (e.g., via wireless network and/or wired network 7-40) at least an indication of a past subjective user state (e.g., depression) associated with the user 7-20a in connection with a past objective occurrence (e.g., overcast weather).

In some implementations, the reception operation 7-1108 may include an operation 7-1310 for receiving a recommendation for a future action as depicted in FIG. 7-13. For instance, the correlation results reception module 7-162 of the mobile device 7-30 receiving (e.g., via wireless network and/or wired network 7-40) at least a recommendation for a future action (e.g., “you should go to sleep early”).

In certain implementations, operation 7-1310 may further include an operation 7-1312 for receiving a justification for the recommendation as depicted in FIG. 7-13. For instance, the correlation results reception module 7-162 of the mobile device 7-30 receiving (e.g., via wireless network and/or wired network 7-40) at least a justification for the recommendation (e.g., “last time you stayed up late, you were very tired the next morning”).

In some implementations, the reception operation 7-1108 may include an operation 7-1314 for receiving an indication of the hypothesis as depicted in FIG. 7-13. For instance, the correlation results reception module 7-162 of the mobile device 7-30 receiving (e.g., via wireless network and/or wired network 7-40) an indication of the hypothesis 7-77. Such an operation may be performed when, for example, the objective occurrence data 7-70* and the subjective user state data 7-60a supports the hypothesis 7-77.

Referring back to FIG. 7-11, the process 7-1100 in various implementations may include a presentation operation 7-1110 to be performed by the mobile device 7-30 for presenting the one or more results of the correlation. For example, the presentation module 7-108′ of the mobile device 7-30 presenting the one or more results of the correlation received by the correlation results reception module 7-162. As described earlier, the presentation operation 7-1110 of FIG. 7-11 in some implementations may completely or substantially mirror the presentation operation 7-810 of FIG. 7-8. For instance, in some implementations, the presentation operation 7-1110 may include, similar to the presentation operation 7-810 of FIG. 7-8, an operation 7-1402 for presenting the one or more results of the correlation via a user interface as depicted in FIG. 7-14. For instance, the user interface indication module 7-259′ of the mobile device 7-30 indicating the one or more results of the correlation via a user interface 7-122′ (e.g., an audio device including one or more speakers and/or a display device such as a LCD or a touchscreen).

In some implementations, operation 7-1402 may further include an operation 7-1404 for indicating the one or more results of the correlation via at least a display device as depicted in FIG. 7-14. For instance, the user interface indication module 7-259′ of the mobile device 7-30 indicating the one or more results of the correlation via a display device (e.g., a display monitor such as a LCD or a touchscreen).

In some implementations, operation 7-1402 may include an operation 7-1406 for indicating the one or more results of the correlation via at least an audio device as depicted in FIG. 7-14. For instance, the user interface indication module 7-259′ of the mobile device 7-30 indicating the one or more results of the correlation via an audio device (e.g., a speaker).

### IX: Hypothesis Development Based on Selective Reported Events

In the following detailed description, reference is made to the accompanying drawings, which form a part hereof. In the drawings, similar symbols typically identify similar components, unless context dictates otherwise. The illustrative embodiments described in the detailed description, drawings, and claims are not meant to be limiting. Other embodiments may be utilized, and other changes may be made, without departing from the spirit or scope of the subject matter presented here.

A recent trend that is becoming increasingly popular in the computing/communication field is to electronically record one's feelings, thoughts, and other aspects of the person's everyday life onto an open diary. One place where such open diaries are maintained are at social networking sites commonly known as “blogs” where users may report or post their latest status, personal activities, and various other aspects of the users' everyday life. The process of reporting or posting blog entries is commonly referred to as blogging. Other social networking sites may allow users to update their personal information via, for example, social networking status reports in which a user may report or post for others to view their current status, activities, and/or other aspects of the user.

A more recent development in social networking is the introduction and explosive growth of microblogs in which individuals or users (referred to as “microbloggers”) maintain open diaries at microblog websites (e.g., otherwise known as “twitters”) by continuously or semi-continuously posting microblog entries. A microblog entry (e.g., “tweet”) is typically a short text message that is usually not more than 140 characters long. The microblog entries posted by a microblogger may report on any aspect of the microblogger's daily life. Typically, such microblog entries will describe the various “events” associated with or are of interest to the microblogger that occurs during a course of a typical day. The microblog entries are often continuously posted during the course of a typical day, and thus, by the end of a normal day, a substantial number of events may have been reported and posted.

Each of the reported events that may be posted through microblog entries may be categorized into one of at least three possible categories. The first category of events that may be reported through microblog entries are “objective occurrences” that may or may not be associated with the microblogger. Objective occurrences that are associated with a microblogger may be any characteristic, incident, happening, or any other event that occurs with respect to the microblogger or are of interest to the microblogger that can be objectively reported by the microblogger, a third party, or by a device. Such events would include, for example, intake of food, medicine, or nutraceutical, certain physical characteristics of the microblogger such as blood sugar level or blood pressure that can be objectively measured, activities of the microblogger observable by others or by a device, activities of others that may or may not be of interest to the microblogger, external events such as performance of the stock market (which the microblogger may have an interest in), performance of a favorite sports team, and so forth. In some cases, objective occurrences may not be at least directly associated with a microblogger. Examples of such objective occurrences include, for example, external events that may not be directly related to the microblogger such as the local weather, activities of others (e.g., spouse or boss) that may directly or indirectly affect the microblogger, and so forth.

A second category of events that may be reported or posted through microblog entries include “subjective user states” of the microblogger. Subjective user states of a microblogger may include any subjective state or status associated with the microblogger that can only be typically reported by the microblogger (e.g., generally cannot be directly reported by a third party or by a device). Such states including, for example, the subjective mental state of the microblogger (e.g., happiness, sadness, anger, tension, state of alertness, state of mental fatigue, jealousy, envy, and so forth), the subjective physical state of the microblogger (e.g., upset stomach, state of vision, state of hearing, pain, and so forth), and the subjective overall state of the microblogger (e.g., “good,” “bad,” state of overall wellness, overall fatigue, and so forth). Note that the term “subjective overall state” as will be used herein refers to those subjective states that may not fit neatly into the other two categories of subjective user states described above (e.g., subjective mental states and subjective physical states).

A third category of events that may be reported or posted through microblog entries include “subjective observations” made by the microblogger. A subjective observation is any subjective opinion, thought, or evaluation relating to any incidence. Examples include, for example, a microblogger's perception about the subjective user state of another person (e.g., “he seems tired”), a microblogger's perception about another person's activities (e.g., “he drank too much yesterday”), a microblogger's perception about an external event (e.g., “it was a nice day today”), and so forth. Although microblogs are being used to provide a wealth of personal information, thus far they have been primarily limited to their use as a means for providing commentaries and for maintaining open diaries.

In accordance with various embodiments, methods, systems, and computer program products are provided to, among other things, develop one or more hypotheses that may be specific to a particular person (e.g. a microblogger) based on selective reported events. The methods, systems, and computer program products may be employed in a variety of environments including, for example, social networking environments, blogging or microblogging environments, instant messaging (IM) environments, or any other type of environment that allows a user to maintain a diary. A “hypothesis,” as referred to herein, may define one or more relationships or links between a first one or more event types (e.g., a type of event such as a particular type of subjective user state, for example, “happy”) and a second one or more event types (e.g., another type of event such as particular type of objective occurrence, for example, favorite sports team winning). In some embodiments, a hypothesis may, at least in part, be defined or represented by an events pattern that indicates or suggests a spatial or a sequential (e.g., time/temporal) relationship between different event types. Such a hypothesis, in some cases, may also indicate the strength or weakness of the link between the different event types. That is, the strength (e.g., soundness) or weakness of the correlation between different event types may depend upon, for example, whether the events pattern repeatedly occurs.

In various embodiments, the development of such a hypothesis may be particularly useful to the user that the hypothesis is associated with. That is, in some cases, the hypothesis may assist the user in modifying his/her future behavior, while in other cases; such a hypothesis may simply alert or notify the user that a pattern of events are repeatedly occurring. In other situations, such a hypothesis may be useful to third parties such as advertisers in order to assist the advertisers in developing a more targeted marketing scheme. In still other situations, such a hypothesis may help in the treatment of ailments associated with the user.

In the case where a hypothesis is being developed for a particular user, such as a microblogger, the methods, systems, and computer program products may be able to disregard or ignore reported events that may not be relevant to the development of the hypothesis. In particular, during a course of a typical day, a user such as microblogger may post a large volume of data that indicates numerous events that may have occurred during the course of the day. It is likely that a vast majority of these reported events may not be relevant to the development of a particular hypothesis. Thus, these methods, systems, and computer program products may distinguish between relevant and non-relevant data. In other words, to disregard or ignore those reported events that may not be relevant to the development of the hypothesis and use only selective reported events for developing the hypothesis. Note that the hypothesis to be developed may or may not determine a causal relationship between multiple events. Instead, the developed hypothesis may merely indicate that there is some sort of relationship (e.g., spatial or time/temporal sequential relationship) between multiple events.

As briefly described above, a hypothesis may be represented by an events pattern that may indicate spatial or sequential (e.g., time or temporal) relationship or relationships between multiple event types. In some implementations, a hypothesis may indicate temporal sequential relationships between multiple event types that merely indicate the temporal relationships between multiple event types. In alternative implementations a hypothesis may indicate a more specific time relationship between multiple event types. For example, a sequential pattern may represent the specific pattern of events that occurs along a timeline that may indicate the specific time intervals between event types.

FIGS. 8-1a and 8-1b illustrate an example environment in accordance with various embodiments. In the illustrated environment, an exemplary system 8-100 may include at least a computing device 8-10 (see FIG. 8-1b). The computing device 8-10, which may be a server (e.g., network server) or a standalone device, may be employed in order to, among other things, acquire events data 8-60* including at least data indicating incidence of a first one or more reported events 8-61* and data indicating incidence of a second one or more reported events 8-62*, where at least one of the first one or more reported events and the second one or more reported events being associated with a user 8-20*. The computing device 8-10 may then be configured to determine an events pattern based selectively on the incidences of the first one or more reported events and the second one or more reported events. Based on the determined events pattern, the computing device 8-10 may then develop a hypothesis associated with the user 8-20*.

As indicated earlier, in some embodiments, the computing device 8-10 may be a server while in other embodiments, the computing device 8-10 may be a standalone device. In the case where the computing device 8-10 is a network server, the computing device 8-10 may communicate indirectly with a user 8-20a via wireless and/or wired network 8-40. In contrast, when the computing device 8-10 is a standalone device, it may communicate directly with a user 8-20b via a user interface 8-122 (see FIG. 8-1b). In the following, “*” indicates a wildcard. Thus, the reference to user 8-20* may indicate a user 8-20a or a user 8-20b of FIGS. 8-1a and 8-1b.

In embodiments in which the computing device 8-10 is a network server, the computing device 8-10 may communicate with a user 8-20a via a mobile device 8-30 and through a wireless and/or wired network 8-40. A network server, as will be described herein, may be in reference to a server located at a single network site or located across multiple network sites or a conglomeration of servers located at multiple network sites. The mobile device 8-30 may be a variety of computing/communication devices including, for example, a cellular phone, a personal digital assistant (PDA), a laptop, a desktop, or other types of computing/communication device that can communicate with the computing device 8-10. In some embodiments, the mobile device 8-30 may be a handheld device such as a cellular telephone, a smartphone, a Mobile Internet Device (MID), an Ultra Mobile Personal Computer (UMPC), a convergent device such as a personal digital assistant (PDA), and so forth.

In embodiments in which the computing device 8-10 is a standalone computing device 8-10 (or simply “standalone device”) that communicates directly with a user 8-20b, the computing device 8-10 may be any type of mobile device 8-30 (e.g., a handheld device) or stationary device (e.g., desktop computer or workstation). For these embodiments, the computing device 8-10 may be a variety of computing/communication devices including, for example, a cellular phone, a personal digital assistant (PDA), a laptop, a desktop, or other types of computing/communication device. In some embodiments, in which the computing device 8-10 is a handheld device, the computing device 8-10 may be a cellular telephone, a smartphone, an MID, an UMPC, a convergent device such as a PDA, and so forth. In various embodiments, the computing device 8-10 may be a peer-to-peer network component device. In some embodiments, the computing device 8-10 and/or the mobile device 8-30 may operate via a Web 2.0 construct (e.g., Web 2.0 application 8-268).

In various embodiments, the computing device 8-10 may be configured to acquire events data 8-60* from one or more sources. Events data 8-60*, as will be described herein, may indicate the occurrences of multiple reported events. Each of the reported events may or may not be associated with a user 8-20*. In some embodiments, a reported event may be associated with the user 8-20* if it is reported by the user 8-20* or it is related to some aspect about the user 8-20* (e.g., the location of the user 8-20*, the local weather of the user 8-20*, activities performed by the user 8-20*, physical characteristics of the user 8-20* as detected by a sensor 8-35, subjective user state of the user 8-20*, and so forth). At least three different types of reported events may be indicated by the events data 8-60*, subjective user states associated with a user 8-20*, objective occurrences, and subjective observations made by the user 8-20* or by others (e.g., third party sources 8-50).

The events data 8-60*, in various embodiments and as illustrated in FIG. 8-1a, may include at least data indicating incidence of a first one or more reported events 8-61* and data indicating incidence of a second one or more reported events 8-62*. In some embodiments, the events data 8-60* may further include data indicating incidence of a third one or more reported events 8-63*. Although not depicted, additional reported events may be indicated by the events data 8-60* in various alternative embodiments.

As will be further described herein, in the following examples and illustrations, the first one or more reported events and the second one or more reported events may form the basis for developing a hypothesis. In contrast, the third one or more reported events may represent events that may not be relevant to the development of the hypothesis. In other words, the third one or more reported events may represent “noise” and may be ignored in the development of a hypothesis. That is, noise data must be accounted for particularly in, for example, the microblogging and social networking environments where much of the reported events posted through microblog entries and status reports may not be relevant to the development of a hypothesis. Such noise data may be filtered out prior to developing a useful hypothesis.

The events data 8-60* including the data indicating incidence of a first one or more reported events 8-61* and the data indicating incidence of a second one or more reported events 8-62* may be obtained from one or more distinct sources (e.g., the original sources for data). For example, in some implementations, a user 8-20* may provide at least a portion of the events data 8-60* (e.g., events data 8-60a that may include data indicating incidence of a first one or more reported events 8-61a, data indicating incidence of a second one or more reported events 8-62a, and/or data indicating incidence of a third one or more reported events 8-63a).

In the same or different embodiments, one or more remote network devices including one or more sensors 8-35 and/or one or more network servers 8-36 may provide at least a portion of the events data 8-60* (e.g., events data 8-60b that may include data indicating incidence of a first one or more reported events 8-61b, data indicating incidence of a second one or more reported events 8-62b, and/or data indicating incidence of a third one or more reported events 8-63b). In same or different embodiments, one or more third party sources may provide at least a portion of the events data 8-60* (e.g., events data 8-60c that may include data indicating incidence of a first one or more reported events 8-61c, data indicating incidence of a second one or more reported events 8-62c, and/or data indicating incidence of a third one or more reported events 8-63c). In still other embodiments, at least a portion of the events data 8-60* may be retrieved from a memory 8-140 in the form of historical data 8-82.

The one or more sensors 8-35 illustrated in FIG. 8-1a may represent a wide range of devices that can monitor various aspects or events associated with a user 8-20a (or user 8-20b). For example, in some implementations, the one or more sensors 8-35 may include devices that can monitor the user's physiological characteristics such as blood pressure sensors, heart rate monitors, glucometers, and so forth. In some implementations, the one or more sensors 8-35 may include devices that can monitor activities of a user 8-20* such as a pedometer, a toilet monitoring system (e.g., to monitor bowel movements), exercise machine sensors, and so forth. The one or more sensors 8-35 may also include other types of sensor/monitoring devices such as video or digital camera, global positioning system (GPS) to provide data that may be related to a user 8-20* (e.g., locations of the user 8-20*), and so forth.

The one or more third party sources 8-50 illustrated in FIG. 8-1a may represent a wide range of third parties and/or the network devices associated with such parties. Examples of third parties include, for example, health care entities (e.g., dental or medical clinic, hospital, physician's office, medical lab, and so forth), content providers, businesses such as retail business, other users (e.g., other microbloggers or other social networking site users), employers, athletic or social groups, educational entities such as colleges and universities, and so forth.

In brief, after acquiring the events data 8-60* from one or more sources, the computing device 8-10 may determine an events pattern based selectively (e.g., by disregarding the third one or more reported events or other noise data) on the incidences of the first one or more reported events and the second one or more reported events as indicated by the events data 8-60*. The events pattern may at least identify the link or relationship (e.g., spatial or sequential relationship) between the first one or more reported events and the second one or more reported events.

After determining the events pattern, the computing device 8-10 may be configured to develop a hypothesis associated with the user 8-20* based, at least in part, on the determined events pattern. The development of the hypothesis may involve creation of a new hypothesis in some cases while in other cases; it may involve the refinement of an already existing hypothesis 8-80. The creation of the hypothesis may be based, in addition to the events pattern, on historical data 8-82 that may be particularly associated with the user 8-20* or with a subgroup of the general population that the user 8-20* belongs to. In some embodiments, the historical data 8-82 may be historical medical data specific to the user 8-20* or to the subgroup of the general population, or may be events data 8-60* that indicate past reported events (that may or may not be associated with the user 8-20*). Other types of past data may also be included in the historical data 8-82 in various alternative embodiments.

After developing the hypothesis, in some implementations, the computing device 8-10 may be designed to execute one or more actions. One such action that may be executed is to present one or more results 8-90 of the hypothesis development operations. For example, the computing device 8-10 may present the results 8-90 to the user 8-20* (e.g., by transmitting the results to the user 8-20a or indicating the results 8-90 to the user 8-20b via a user interface 8-122), to one or more third parties (e.g., one or more third party sources 8-50), and/or to one or more remote network devices (e.g., network servers 8-36). The results 8-90 to be presented may include the developed hypothesis, an advisory based on the hypothesis, a recommendation based on the hypothesis, or other types of results.

As illustrated in FIG. 8-1b, computing device 8-10 may include one or more components and/or sub-modules. As those skilled in the art will recognize, these components and sub-modules may be implemented by employing hardware (e.g., in the form of circuitry such as application specific integrated circuit or ASIC, field programmable gate array or FPGA, or other types of circuitry), software, a combination of both hardware and software, or a general purpose computing device 8-10 executing instructions included in a signal-bearing medium. In various embodiments, computing device 8-10 may include an events data acquisition module 8-102, an events pattern determination module 8-104, a hypothesis development module 8-106, an action execution module 8-108, a network interface 8-120 (e.g., network interface card or NIC), a user interface 8-122 (e.g., a display monitor, a touchscreen, a keypad or keyboard, a mouse, an audio system including a microphone and/or speakers, an image capturing system including digital and/or video camera, and/or other types of interface devices), one or more applications 8-126 (e.g., a web 2.0 application, a voice recognition application, and/or other applications that may be stored in a memory 8-140), and/or memory 8-140, which may include one or more existing hypothesis 8-80 and/or historical data 8-82.

The events data acquisition module 8-102 may be configured to, among other things, acquire events data 8-60* from one or more distinct sources. The events data 8-60* to be acquired by the events data acquisition module 8-102 may include at least data indicating incidence of a first one or more reported events 8-61* and data indicating incidence of a second one or more reported events 8-62*. At least one of the first one or more reported events 8-61* and the second one or more reported events 8-62* may be associated with a user 8-20*. The events data acquisition module 8-102 may also be designed to acquire data indicating incidence of a third one or more reported events 8-63* and other data indicating additional reported events from various sources.

Referring now to FIG. 8-2a illustrating particular implementations of the events data acquisition module 8-102 of the computing device 8-10 of FIG. 8-1b. The events data acquisition module 8-102 may include a reception module 8-202 for receiving at least one of the data indicating incidence of the first one or more reported events 8-61* and the data indicating incidence of the second one or more reported events 8-62*. The reception module 8-202 may further include a user interface reception module 8-204 and/or a network interface reception module 8-206. The user interface reception module 8-204 may be configured to receive, via a user interface 8-122, the events data 8-60* including at least one of the data indicating incidence of the first one or more reported events 8-61* and the data indicating incidence of the second one or more reported events 8-62*. In contrast, the network interface reception module 8-206 may be configured to receive (e.g., via network interface 8-120) from a wireless and/or wired network 8-40 the events data 8-60* including at least one of the data indicating incidence of the first one or more reported events 8-61* and the data indicating incidence of the second one or more reported events 8-62*.

The events pattern determination module 8-104 of the computing device 8-10 of FIG. 8-1b may be configured to, among other things, determine an events pattern based selectively on the incidences of the first one or more reported events and the second one or more reported events as indicted by the acquired events data 8-60*. In various implementations, the events pattern to be determined may at least indicate one or more spatial or sequential (e.g., time or temporal) relationships or links between the first one or more reported events and the second one or more reported events.

FIG. 8-2b illustrates particular implementations of the events pattern determination module 8-104 of FIG. 8-1b. As illustrated, the events pattern determination module 8-104 may include an exclusion module 8-208 configured to exclude from the determination of the events pattern, noise data such as a third one or more reported events (e.g., data indicating incidence of a third one or more reported events 8-63*). In various implementations, the exclusion module 8-208 may further include a filter module 8-210 configured to filter the events data 8-60* to filter out noise data including the data indicating incidence of a third one or more reported events 8-63*. The filter module 8-210 may also include a historical data referencing module 8-212 and/or a hypothesis referencing module 8-214. The historical data referencing module 8-212 may be designed to reference historical data 8-82 to facilitate the filter module 8-210 in order to filter out noise data (e.g., data relating to reported events that are not relevant to the development of a hypothesis) from the events data 8-60*. In various implementations, the historical data 8-82 to be referenced may identify and link or associate at least two event types (e.g., a subjective user state and a subjective observation). In contrast, the hypothesis referencing module 8-214 may be designed to reference an existing hypothesis 8-80 to facilitate the filter module 8-210 to filter the events data 8-60*. In various implementations, the existing hypothesis 8-80 to be referenced may be specific to the user 8-20* or to a subgroup of the general population, the user 8-20* being part of the subgroup.

The hypothesis development module 8-106 of the computing device 8-10 of FIG. 8-1b may be configured to, among other things, develop a hypothesis associated with the user 8-20* based, at least in part, on the events pattern determined by the events pattern determination module 8-104. In various implementations, the development of the hypothesis may involve creating a new hypothesis or updating or refining an existing hypothesis 8-80. The hypothesis to be developed may indicate one or more relationships (e.g., spatial or sequential relationships) between a first one or more event types and a second one or more event types. In various implementations, the hypothesis to be developed may also indicate the strength or weakness of the hypothesis.

FIG. 8-2c illustrates particular implementations of the hypothesis development module 8-106 of FIG. 8-1b. As illustrated, the hypothesis development module 8-106 may include a hypothesis creation module 8-216 configured to create a hypothesis based, at least in part, on the determined events pattern (e.g., the first one or more reported events and the second one or more reported events associated with the events pattern) and based on historical data 8-82 (e.g., historical data 8-82 that may be particular to the user 8-20*. The hypothesis creation module 8-216 may further include a historical data referencing module 8-220 configured to reference historical data 8-82 in order to facilitate in the creation of a hypothesis by the hypothesis creation module 8-216.

In various implementations, the hypothesis development module 8-106 may include a determination module 8-222 to facilitate in the further development of an existing hypothesis 8-80. In particular, the determination module 8-222 may be configured to determine whether the events pattern determined by, for example, the events pattern determination module 8-104 supports an existing hypothesis 8-82 associated with the user 8-20*. The determination module 8-222 may further include a comparison module 8-224 designed to compare the events pattern determined by, for example, the events pattern determination module 8-104 to an events pattern associated with the existing hypothesis 8-80 (e.g., an events pattern that links a first one or more event types with a second one or more event types) to determine whether the determined events pattern supports the existing hypothesis 8-80.

The comparison module 8-224 may also include a strength determination module 8-226 and/or a weakness determination module 8-228. In various implementations, the strength determination module 8-226 may be designed to determine the strength (e.g., soundness) of the existing hypothesis 8-80 associated with the user 8-20* based, at least in part on the comparison made by the comparison module 8-224. In particular, the strength determination module 8-226 may determine the strength of the relationship (or link) between a first one or more event types and a second one or more event types identified by the existing hypothesis 8-80 based on the comparison made by the comparison module 8-224. Note that if the determined events pattern exactly or substantially matches the events pattern associated with the existing hypothesis 8-80, then that may lead to the conclusion that the existing hypothesis 8-80 is relatively sound.

In contrast, the weakness determination module 8-228 may be designed to determine the weakness of the existing hypothesis 8-80 associated with the user 8-20* based, at least in part on the comparison made by the comparison module 8-224. In particular, the weakness determination module 8-228 may determine the weakness of the relationship (or link) between a first one or more event types and a second one or more event types identified by the existing hypothesis 8-82 based on the comparison made by the comparison module 8-224. Note that if the determined events pattern is completely or substantially dissimilar to the events pattern associated with the existing hypothesis 8-80, then that may lead to the conclusion that the existing hypothesis 8-80 is relatively weak. The strength or weakness relating the existing hypothesis 8-80, as determined by the strength determination module 8-226 or the weakness determination module 8-228, may be added to the existing hypothesis 8-80 to further develop or refine the existing hypothesis 8-80.

In various implementations, the hypothesis development module 8-106 may include a determined events pattern referencing module 8-230 configured to reference events pattern that have been determined by, for example, the events pattern determination module 8-104. Such referencing of the determined events pattern may facilitate the hypothesis development module 8-106 in developing a hypothesis associated with the user 8-20*.

The action execution module 8-108 of the computing device 8-10 may be configured to execute one or more actions in response to, for example, the hypothesis development module 8-106 developing the hypothesis. Referring now to FIG. 8-2d illustrating particular implementations of the action execution module 8-108 of FIG. 8-lb. In various implementations, the action execution module 8-108 may include a presentation module 8-232 that may be configured to present (e.g., transmit via a network interface 8-120 or to indicate via a user interface 8-122) one or more results of the development of, for example, the hypothesis by the hypothesis development module 8-106. The presentation module 8-232 may further include one or more sub-modules including, for example, a transmission module 8-234, an indication module 8-236, a hypothesis presentation module 8-238, a hypothesis confirmation presentation module 8-240, a hypothesis soundness/weakness presentation module 8-242, an advisory presentation module 8-244, and/or a recommendation presentation module 8-246.

The transmission module 8-234 may be designed to, for example, transmit the one or more results of the developing of the hypothesis via a wireless and/or wired network 8-40. In various implementations, the one or more results 8-90 may be transmitted to the user 8-20*, one or more third parties (e.g., one or more third party sources 8-50), and/or to one or more remote network devices such as one or more network servers 8-36. In contrast, the indication module 8-236 may be designed to, for example, indicate the one or more results 8-90 via a user interface 8-122. The hypothesis presentation module 8-238 may be configured to present (e.g., transmit or indicate) the hypothesis developed by, for example, the hypothesis development module 8-106. In contrast, the hypothesis confirmation presentation module 8-240 may be configured to present (e.g., transmit or indicate) an indication of a confirmation of the hypothesis (e.g., existing hypothesis 8-80).

The hypothesis soundness/weakness presentation module 8-242 may be configured to present (e.g., transmit or indicate) an indication of the soundness or weakness of the hypothesis. Note that the words “soundness” and “strength” have been used interchangeably in reference to a hypothesis and therefore, are synonymous unless indicated otherwise. The advisory presentation module 8-244 may be configured to, among other things, presenting (e.g., transmit or indicate) an advisory of one or more past events. The recommendation presentation module 8-246 may be configured to present a recommendation for a future action based, for example, on the hypothesis.

In various implementations, the action execution module 8-108 may include a monitoring module 8-250 that may be configured to, among other things, monitor reported events. The monitoring of the reported events may involve determining whether the reported events include events that match or substantially match the types of events identified by the hypothesis. Upon detecting such events, additional actions may be taken such as soliciting for additional events data 8-60* in order to confirm, for example, the veracity of the hypothesis or generating an advisory to the user 8-20* or to one or more third party sources 8-50 regarding, for example, the possibility of the pattern of events identified by the hypothesis occurring.

FIG. 8-2e depicts particular implementations of the one or more applications 8-126 of the computing device 8-10 of FIG. 8-1b. The one or more applications 8-126 may include, for example, one or more communication applications 8-267 (e.g., text messaging application, instant messaging application, email application, voice recognition system, and so forth) and/or Web 2.0 application 8-268 to facilitate in communicating via, for example, the World Wide Web. In various implementations, the one or more applications 8-126 may be stored in the memory 8-140.

The network interface 8-120 of the computing device 8-10 may be a device designed to interface with a wireless and/or wired network 8-40. Examples of such devices include, for example, a network interface card (NIC) or other interface devices or systems for communicating through at least one of a wireless network or wired network 8-40. The user interface 8-122 of the computing device 8-10 may comprise any device that may interface with a user 8-20b. Examples of such devices include, for example, a keyboard, a display monitor, a touchscreen, a microphone, a speaker, an image capturing device such as a digital or video camera, a mouse, and so forth.

The memory 8-140 of the computing device 8-10 may include any type of volatile or non-volatile device used to store data. Examples of a memory 8-140 include, for example, a mass storage device, read only memory (ROM), programmable read only memory (PROM), erasable programmable read-only memory (EPROM), random access memory (RAM), flash memory, synchronous random access memory (SRAM), dynamic random access memory (DRAM), and so forth.

The various features and characteristics of the components, modules, and sub-modules of the computing device 8-10 presented thus far will be described in greater detail with respect to the processes and operations to be described herein.

FIG. 8-3 illustrates an operational flow 8-300 representing example operations related to, among other things, hypothesis development based, at least in part, on selective reported events. In some embodiments, the operational flow 8-300 may be executed by, for example, the computing device 8-10 of FIG. 8-1b, which may be a server or a standalone device.

In FIG. 8-3 and in the following figures that include various examples of operational flows, discussions and explanations may be provided with respect to the above-described exemplary environment of FIGS. 8-1a and 8-1b, and/or with respect to other examples (e.g., as provided in FIGS. 8-2a to 8-2e) and contexts. However, it should be understood that the operational flows may be executed in a number of other environments and contexts, and/or in modified versions of FIGS. 8-1a, 8-1b, and 8-2a to 8-2e. Also, although the various operational flows are presented in the sequence(s) illustrated, it should be understood that the various operations may be performed in different sequential orders other than those which are illustrated, or may be performed concurrently.

Further, in the following figures that depict various flow processes, various operations may be depicted in a box-within-a-box manner. Such depictions may indicate that an operation in an internal box may comprise an optional example embodiment of the operational step illustrated in one or more external boxes. However, it should be understood that internal box operations may be viewed as independent operations separate from any associated external boxes and may be performed in any sequence with respect to all other illustrated operations, or may be performed concurrently.

In any event, after a start operation, the operational flow 8-300 may move to an events data acquisition operation 8-302 for acquiring events data including data indicating incidence of a first one or more reported events and data indicating incidence of a second one or more reported events, at least one of the first one or more reported events and the second one or more reported events being associated with a user. For instance, the events data acquisition module 8-102 of the computing device 8-10 acquiring (e.g., acquiring from a user 8-20*, from one or more third party sources 8-50, from one or more sensors 8-35, and/or from memory 8-140) events data 8-60* including data indicating incidence of a first one or more reported events 8-61* and data indicating incidence of a second one or more reported events 8-62*, at least one of the first one or more reported events (e.g., subjective user states such as fatigue) and the second one or more reported events (e.g., objective occurrences such as going to sleep after midnight) being associated with a user 8-20*.

Next, operational flow 8-300 may include an events pattern determination operation 8-304 for determining an events pattern based selectively on the incidences of the first one or more reported events and the second one or more reported events. For instance, the events pattern determination module 8-104 of the computing device 8-10 determining an events pattern (e.g., a spatial events pattern or a time/temporal sequential events pattern) based selectively (e.g., by disregarding or filtering out non-relevant events data) on the incidences of the first one or more reported events (e.g., objective occurrences such as a user 8-20* meeting with the boss) and the second one or more reported events (e.g., subjective observations such as a third party observing that the user 8-20* appears to be angry).

Finally, operational flow 8-300 may include a hypothesis development operation 8-306 for developing a hypothesis associated with the user based, at least in part, on the determined events pattern. For instance, the hypothesis development module 8-106 of the computing device 8-10 developing a hypothesis (e.g., creating a new hypothesis or further developing an existing hypothesis 8-80) associated with the user 8-20* based, at least in part, on the events pattern determined, for example, by the events pattern determination module 8-104.

In various implementations, the events data acquisition operation 8-302 of FIG. 8-3 may be executed in a number of different ways as will be illustrated in FIGS. 8-4a, 8-4b, 8-4c, 8-4d, 8-4e, 8-4f, 8-4g, 8-4h, and 8-4i. For example, in some implementations, the events data acquisition operation 8-302 may include a reception operation 8-402 for receiving at least one of the data indicating incidence of a first one or more reported events and the data indicating incidence of a second one or more reported events as depicted in FIG. 8-4a. For instance, the reception module 8-202 of the computing device 8-10 receiving (e.g., via the network interface 8-120 or via the user interface 8-122) at least one of the data indicating incidence of a first one or more reported events 8-61* and the data indicating incidence of a second one or more reported events 8-62*.

In various implementations, the reception operation 8-402 may be performed in a number of different ways depending on the particular circumstances. For example, in some implementations, the reception operation 8-402 may include an operation 8-403 for receiving at least one of the data indicating incidence of a first one or more reported events and the data indicating incidence of a second one or more reported events via a user interface as depicted in FIG. 8-4a. For instance, the user interface reception module 8-204 (see FIG. 8-2a) of the computing device 8-10 receiving at least one of the data indicating incidence of a first one or more reported events 8-61a and the data indicating incidence of a second one or more reported events 8-62a via a user interface 8-122 (e.g., a touchscreen, a keypad, a mouse, a microphone, and so forth).

Operation 8-403, in turn, may further include an operation 8-404 for receiving at least one of the data indicating incidence of a first one or more reported events and the data indicating incidence of a second one or more reported events from the user as depicted in FIG. 8-4a. For instance, the user interface reception module 8-204 of the computing device 8-10 receiving at least one of the data indicating incidence of a first one or more reported events 8-61a and the data indicating incidence of a second one or more reported events 8-62a from the user 8-20b.

In the same or different implementations, the reception operation 8-402 may include an operation 8-405 for receiving at least one of the data indicating incidence of a first one or more reported events and the data indicating incidence of a second one or more reported events via at least one of a wireless network or a wired network as depicted in FIG. 8-4a. For instance, the network interface reception module 8-206 of the computing device 8-10 receiving (e.g., in the form of one or more microblog entries, one or more status reports, one or more electronic messages, and so forth) at least one of the data indicating incidence of a first one or more reported events 8-61* and the data indicating incidence of a second one or more reported events 8-62* via at least one of a wireless network or a wired network 8-40.

Depending upon circumstances, the data indicating incidence of a first one or more reported events 8-61* and/or the data indicating incidence of a second one or more reported events 8-62* received via the wireless and/or a wired network 8-40 may be provided by one or more different sources. For example, in some implementations, operation 8-405 may include an operation 8-406 for receiving at least one of the data indicating incidence of a first one or more reported events and the data indicating incidence of a second one or more reported events from the user as depicted in FIG. 8-4a. For instance, the network interface reception module 8-206 of the computing device 8-10 receiving (e.g., via a network interface 8-120 such as a network interface card or “NIC”) at least one of the data indicating incidence of a first one or more reported events 8-61a and the data indicating incidence of a second one or more reported events 8-62a from the user 8-20a.

In the same or different implementations, operation 8-405 may include an operation 8-407 for receiving at least one of the data indicating incidence of a first one or more reported events and the data indicating incidence of a second one or more reported events from one or more remote network devices as depicted in FIG. 8-4a. For instance, the network interfaced reception module 8-206 of the computing device 8-10 receiving (e.g., via a network interface 8-120 such as a NIC) at least one of the data indicating incidence of a first one or more reported events 8-61b and the data indicating incidence of a second one or more reported events 8-62b from one or more remote network devices (e.g., one or more sensors 8-35 and/or one or more network servers 8-36).

In the same or different implementations, operation 8-405 may include an operation 8-408 for receiving at least one of the data indicating incidence of a first one or more reported events and the data indicating incidence of a second one or more reported events from one or more third party sources as depicted in FIG. 8-4a. For instance, the network interface reception module 8-206 of the computing device 8-10 receiving (e.g., via a network interface 8-120 such as a NIC) at least one of the data indicating incidence of a first one or more reported events 8-61c and the data indicating incidence of a second one or more reported events 8-62c from one or more third party sources 8-50.

The one or more third party sources 8-50, as referred to above, may be in reference to various third parties (and/or the network devices that are associated with such parties). For example, in some implementations, operation 8-408 may include an operation 8-409 for receiving at least one of the data indicating incidence of a first one or more reported events and the data indicating incidence of a second one or more reported events from one or more content providers as depicted in FIG. 8-4b. For instance, the network interface reception module 8-206 of the computing device 8-10 receiving (e.g., via a network interface 8-120 such as a NIC) at least one of the data indicating incidence of a first one or more reported events 8-61c and the data indicating incidence of a second one or more reported events 8-62c from one or more content providers.

In some implementations, operation 8-408 may include an operation 8-410 for receiving at least one of the data indicating incidence of a first one or more reported events and the data indicating incidence of a second one or more reported events from one or more other users as depicted in FIG. 8-4b. For instance, the network interface reception module 8-206 of the computing device 8-10 receiving (e.g., via a network interface 8-120 such as a NIC) at least one of the data indicating incidence of a first one or more reported events 8-61c and the data indicating incidence of a second one or more reported events 8-62c from one or more other users (e.g., microbloggers).

In some implementations, operation 8-408 may include an operation 8-411 for receiving at least one of the data indicating incidence of a first one or more reported events and the data indicating incidence of a second one or more reported events from one or more health care entities as depicted in FIG. 8-4b. For instance, the network interface reception module 8-206 of the computing device 8-10 receiving (e.g., via a network interface 8-120 such as a NIC) at least one of the data indicating incidence of a first one or more reported events 8-61c and the data indicating incidence of a second one or more reported events 8-62c from one or more health care entities (e.g., hospital, medical or dental clinic, medical labs, and so forth).

In some implementations, operation 8-408 may include an operation 8-412 for receiving at least one of the data indicating incidence of a first one or more reported events and the data indicating incidence of a second one or more reported events from one or more business entities as depicted in FIG. 8-4b. For instance, the network interface reception module 8-206 of the computing device 8-10 receiving (e.g., via a network interface 8-120 such as a NIC) at least one of the data indicating incidence of a first one or more reported events 8-61c and the data indicating incidence of a second one or more reported events 8-62c from one or more business entities (e.g., merchants, internet websites, place of employment, and so forth).

In some implementations, operation 8-408 may include an operation 8-413 for receiving at least one of the data indicating incidence of a first one or more reported events and the data indicating incidence of a second one or more reported events from one or more social or athletic groups as depicted in FIG. 8-4b. For instance, the network interface reception module 8-206 of the computing device 8-10 receiving (e.g., via a network interface 8-120 such as a NIC) at least one of the data indicating incidence of a first one or more reported events 8-61c and the data indicating incidence of a second one or more reported events 8-62c from one or more social or athletic groups (e.g., sports clubs, PTA, and so forth).

The data received during the reception operation 8-402 may be received in a variety of different forms. For example, in some implementations, the reception operation 8-402 may include an operation 8-414 for receiving at least one of the data indicating incidence of a first one or more reported events and the data indicating incidence of a second one or more reported events via one or more blog entries as depicted in FIG. 8-4c. For instance, the reception module 8-202 of the computing device 8-10 receiving at least one of the data indicating incidence of a first one or more reported events 8-61* and the data indicating incidence of a second one or more reported events 8-62* via one or more blog entries (e.g., microblog entries).

In the same or different implementations, the reception operation 8-402 may include an operation 8-415 for receiving at least one of the data indicating incidence of a first one or more reported events and the data indicating incidence of a second one or more reported events via one or more status reports as depicted in FIG. 8-4c. For instance, the reception module 8-202 of the computing device 8-10 receiving at least one of the data indicating incidence of a first one or more reported events 8-61* and the data indicating incidence of a second one or more reported events 8-62* via one or more status reports (e.g., social networking status reports).

In the same or different implementations, the reception operation 8-402 may include an operation 8-416 for receiving at least one of the data indicating incidence of a first one or more reported events and the data indicating incidence of a second one or more reported events via one or more electronic messages as depicted in FIG. 8-4c. For instance, the reception module 8-202 of the computing device receiving at least one of the data indicating incidence of a first one or more reported events 8-61* and the data indicating incidence of a second one or more reported events 8-62* via one or more electronic messages (e.g., text messages, email messages, instant messages, and so forth).

In various implementations, the data acquired through the events data acquisition operation 8-302 of FIG. 8-3 may include data that may indicate incidences of one or more subjective user states. For example, in some implementations, the events data acquisition operation 8-302 may include an operation 8-417 for acquiring data indicating incidence of a first one or more reported events and data indicating incidence of a second one or more reported events that includes data indicating at least one subjective user state associated with the user as provided by the user as depicted in FIG. 8-4d. For instance, the events data acquisition module 8-102 of the computing device 8-10 acquiring data indicating incidence of a first one or more reported events 8-61a and data indicating incidence of a second one or more reported events 8-62a that includes data indicating at least one subjective user state associated with the user 8-20* as provided by the user 8-20* (e.g., as provided by the user 8-20* via a user interface 8-122, via a wireless and/or wired network 8-40, via network servers 8-36, via memory 8-140, or through one or more third party sources 8-50).

One or more types of subjective user states may be indicated by the data acquired through operation 8-417. For example, in some implementations, operation 8-417 may include an operation 8-418 for acquiring data indicating at least one subjective mental state associated with the user as depicted in FIG. 8-4d. For instance, the events data acquisition module 8-102 of the computing device 8-10 acquiring data indicating at least one subjective mental state (e.g., anger, happiness, fatigued, alertness, jealousy, fear, nausea, and so forth) associated with the user 8-20*.

In the same or different implementations, operation 8-417 may include an operation 8-419 for acquiring data indicating at least one subjective physical state associated with the user as depicted in FIG. 8-4d. For instance, the events data acquisition module 8-102 of the computing device 8-10 acquiring data indicating at least one subjective physical state (e.g., sore ankle or upset stomach) associated with the user 8-20*.

In the same or different implementations, operation 8-417 may include an operation 8-420 for acquiring data indicating at least one subjective overall state associated with the user as depicted in FIG. 8-4d. For instance, the events data acquisition module 8-102 of the computing device 8-10 of acquiring data indicating at least one subjective overall state (e.g., “good,” “bad,” “well,” and so forth) associated with the user 8-20*.

In some implementations, operation 8-417 may include an operation 8-421 for acquiring data indicating at least a second subjective user state associated with the user as provided by the user as depicted in FIG. 8-4d. For instance, the events data acquisition module 8-102 of the computing device 8-10 acquiring (e.g., by receiving from the user 8-20* or by retrieving from memory 8-140) data indicating at least a second subjective user state (e.g., a subjective mental state, a subjective physical state, or a subjective overall state) associated with the user 8-20* as provided by the user 8-20* (e.g., as provided by the user 8-20* via a user interface 8-122, via a wireless and/or wired network 8-40, via network servers 8-36, via memory 8-140, or through one or more third party sources 8-50).

In some implementations, operation 8-421 may further include an operation 8-422 for acquiring data indicating one subjective user state associated with a first point or interval in time and data indicating a second subjective user state associated with a second point or interval in time as depicted in FIG. 8-4d. For instance, the events data acquisition module 8-202 of the computing device 8-10 acquiring data indicating one subjective user state (e.g., elation) associated with a first point or interval in time and data indicating a second subjective user state (e.g., depression) associated with a second point or interval in time.

In various implementations, the data acquired through the events data acquisition operation 8-302 of FIG. 8-3 may include data that may indicate one or more objective occurrences. For example, in some implementations, the events data acquisition operation 8-302 may include an operation 8-423 for acquiring data indicating incidence of a first one or more reported events and data indicating incidence of a second one or more reported events that includes data indicating at least one objective occurrence as depicted in FIG. 8-4e. For instance, the events data acquisition module 8-102 of the computing device 8-10 acquiring data indicating incidence of a first one or more reported events 8-61* and data indicating incidence of a second one or more reported events 8-62* that includes data indicating at least one objective occurrence (e.g., an objectively observable activity performed by the user 8-20* or an objectively observable external event).

One or more types of objective occurrences may be indicated by the data acquired through operation 8-423. For example, in some implementations, operation 8-423 may include an operation 8-424 for acquiring data indicating at least an ingestion by the user of a medicine as depicted in FIG. 8-4e. For instance, the events data acquisition module 8-102 of the computing device 8-10 acquiring data indicating at least an ingestion by the user 8-20* of a medicine (e.g., a dose of aspirin).

In some implementations, operation 8-423 may include an operation 8-425 for acquiring data indicating at least an ingestion by the user of a food item as depicted in FIG. 8-4e. For instance, the events data acquisition module 8-102 of the computing device 8-10 acquiring data indicating at least an ingestion by the user 8-20* of a food item (e.g., 24 ounces of Filipino beer).

In some implementations, operation 8-423 may include an operation 8-426 for acquiring data indicating at least an ingestion by the user of a nutraceutical as depicted in FIG. 8-4e. For instance, the events data acquisition module 8-102 of the computing device 8-10 acquiring data indicating at least an ingestion by the user 8-20* of a nutraceutical (e.g., four ounces of red grapes).

Other types of activities executed by the user 8-20* or by one or more third parties (e.g., third party sources 8-50) may be indicated by data acquired during operation 8-423. For example, in some implementations, operation 8-423 may include an operation 8-427 for acquiring data indicating at least an exercise routine executed by the user as depicted in FIG. 8-4e. For instance, the events data acquisition module 8-102 of the computing device 8-10 acquiring data indicating at least an exercise routine executed by the user 8-20* (e.g., walking for 45 minutes). Note that the events data acquisition module 8-102 may be configured to acquire data indicating objectively observable activities of the user 8-20* or one or more third parties in various alternative implementations. In the same or different implementations, the events data acquisition module 8-102 may be configured to acquire data indicating objectively observable external events as will be illustrated in the following.

In some implementations, operation 8-423 may include an operation 8-428 for acquiring data indicating at least a social activity routine executed by the user as depicted in FIG. 8-4e. For instance, the events data acquisition module 8-102 of the computing device 8-10 acquiring data indicating at least a social activity routine executed by the user 8-20* (e.g., dinner with girlfriend).

In some implementations, operation 8-423 may include an operation 8-429 for acquiring data indicating at least an activity performed by one or more third parties as depicted in FIG. 8-4e. For instance, the events data acquisition module 8-102 of the computing device 8-10 acquiring data indicating at least an activity performed by one or more third parties (e.g., spouse leaving for a business trip).

In some implementations, operation 8-423 may include an operation 8-430 for acquiring data indicating one or more physical characteristics associated with the user as depicted in FIG. 8-4e. For instance, the events data acquisition module 8-102 of the computing device 8-10 acquiring data indicating one or more physical characteristics associated with the user 8-20* (e.g., blood pressure).

In some implementations, operation 8-423 may include an operation 8-431 for acquiring data indicating a resting, a learning, or a recreational activity by the user as depicted in FIG. 8-4e. For instance, the events data acquisition module 8-102 of the computing device 8-10 acquiring data indicating a resting (e.g., napping), a learning (e.g., attending a class or reading a book), or a recreational activity (e.g., golfing) by the user 8-20*.

In some implementations, operation 8-423 may include an operation 8-432 for acquiring data indicating occurrence of one or more external events as depicted in FIG. 8-4f. For instance, the events data acquisition module 8-102 of the computing device 8-10 acquiring data indicating occurrence of one or more external events (e.g., weather or performance of favorite baseball team).

In some implementations, operation 8-423 may include an operation 8-433 for acquiring data indicating one or more locations associated with the user as depicted in FIG. 8-4f. For instance, the events data acquisition module 8-102 of the computing device 8-10 acquiring data indicating one or more locations associated with the user 8-20* (e.g., place of employment).

In some implementations, operation 8-423 may include an operation 8-434 for acquiring data indicating at least a second objective occurrence as depicted in FIG. 8-4f. For instance, the events data acquisition module 8-102 of the computing device 8-10 acquiring data indicating at least a second objective occurrence.

In various implementations, operation 8-434 may comprise of an operation 8-435 for acquiring data indicating one objective occurrence associated with a first point or interval in time and data indicating a second objective occurrence associated with a second point or interval in time as depicted in FIG. 8-4f. For instance, the events data acquisition module 8-102 of the computing device 8-10 acquiring data indicating one objective occurrence (e.g., eating ice cream) associated with a first point or interval in time and data indicating a second objective occurrence (e.g., high blood sugar level) associated with a second point or interval in time.

The data acquired in the events data acquisition operation 8-302 of FIG. 8-3 in various implementations may include data that indicates one or more subjective observations. For example, in some implementations, the events data acquisition operation 8-302 may include an operation 8-436 for acquiring data indicating incidence of a first one or more reported events and data indicating incidence of a second one or more reported events that includes data indicating at least one subjective observation as depicted in FIG. 8-4g. For instance, the events data acquisition module 8-102 of the computing device 8-10 acquiring data indicating incidence of a first one or more reported events 8-61* and data indicating incidence of a second one or more reported events 8-62* that includes data indicating at least one subjective observation (e.g., an observation made by a person regarding the perceived subjective user state of another person).

Note that although a subjective observation may be made by a particular person such as user 8-20*, the data that indicates the subjective observation may be provided by the user 8-20*, by one or more third party sources 8-50 (e.g., other users), by one or more remote network devices such as network servers 8-36, or by any other entities that may have access to such data. In other words, the user 8-20* who may have made the actual subjective observation may provide indication of his/her observation to other parties/entities that may ultimately disseminate such information.

In various implementations, operation 8-436 may include one or more additional operations. For example, in some implementations, operation 8-436 may include an operation 8-437 for acquiring data indicating at least one subjective observation made by a second user regarding the user as depicted in FIG. 8-4g. For instance, the events data acquisition module 8-102 of the computing device 8-10 acquiring data indicating at least one subjective observation (e.g., perceived unhappiness) made by a second user (e.g., third party source 8-50) regarding the user 8-20*.

Operation 8-437, in turn, may further include one or more additional operations. For example, in some implementations, operation 8-437 may include an operation 8-438 for acquiring data indicating at least one subjective observation, as made by the second user, regarding a perceived subjective user state of the user as depicted in FIG. 8-4g. For instance, the events data acquisition module 8-102 of the computing device 8-10 acquiring data indicating at least one subjective observation, as made by the second user (e.g., third party source 8-50), regarding a perceived subjective user state (e.g., happy) of the user 8-20*.

In various implementations, operation 8-438 may further comprise one or more operations. For example, in some implementations, operation 8-438 may include an operation 8-439 for acquiring data indicating at least one subjective observation, as made by the second user, regarding a perceived subjective mental state of the user as depicted in FIG. 8-4g. For instance, the events data acquisition module 8-102 of the computing device 8-10 acquiring data indicating at least one subjective observation, as made by the second user, regarding a perceived subjective mental state (e.g., anger) of the user 8-20*.

In some implementations, operation 8-438 may include an operation 8-440 for acquiring data indicating at least one subjective observation, as made by the second user, regarding a perceived subjective physical state of the user as depicted in FIG. 8-4g. For instance, the events data acquisition module 8-102 of the computing device 8-10 acquiring data indicating at least one subjective observation, as made by the second user, regarding a perceived subjective physical state (e.g., sore ankle) of the user 8-20*.

In some implementations, operation 8-438 may include an operation 8-441 for acquiring data indicating at least one subjective observation made by the second user regarding a perceived subjective overall state of the user as depicted in FIG. 8-4g. For instance, the events data acquisition module 8-102 of the computing device 8-10 acquiring data indicating at least one subjective observation, as made by the second user, regarding a perceived subjective overall state (e.g., “bad”) of the user 8-20*.

In various implementations, operation 8-437 may include an operation 8-442 for acquiring data indicating at least one subjective observation made by the second user regarding an activity performed by the user as depicted in FIG. 8-4g. For instance, the events data acquisition module 8-102 of the computing device 8-10 acquiring data indicating at least one subjective observation made by the second user regarding an activity (e.g., ate too much for dinner) performed by the user 8-20*.

In various implementations, operation 8-436 may include an operation 8-443 for acquiring data indicating at least one subjective observation of an occurrence of an external event as depicted in FIG. 8-4h. For instance, the events data acquisition module 8-102 of the computing device 8-10 acquiring data indicating at least one subjective observation (e.g., as made by the user 8-20* or by a third party) regarding an occurrence of an external event (e.g., “good weather”).

In some implementations, operation 8-436 may include an operation 8-444 for acquiring data indicating at least one subjective observation made by the user regarding a second user as depicted in FIG. 8-4h. For instance, the events data acquisition module 8-102 of the computing device 8-10 acquiring data indicating at least one subjective observation made by the user 8-20* regarding a second user (e.g., a third party source 8-50 such as another user). Various types of subjective observations regarding a second user may be indicated by the data acquired through operation 8-444.

For example, in some implementations, operation 8-444 may include an operation 8-445 for acquiring data indicating at least one subjective observation made by the user regarding a perceived subjective mental state of the second user as depicted in FIG. 8-4h. For instance, the events data acquisition module 8-102 of the computing device 8-10 acquiring data indicating at least one subjective observation made by the user 8-20* regarding a perceived subjective mental state of the second user (e.g., “he appears to be confused”).

In the same or different implementations, operation 8-444 may include an operation 8-446 for acquiring data indicating at least one subjective observation made by the user regarding a perceived subjective physical state of the second user as depicted in FIG. 8-4h. For instance, the events data acquisition module 8-102 of the computing device 8-10 acquiring data indicating at least one subjective observation made by the user 8-20* regarding a perceived subjective physical state of the second user (e.g., “he appears to have a cramp”).

In the same or different implementations, operation 8-444 may include an operation 8-447 for acquiring data indicating at least one subjective observation made by the user regarding a perceived subjective overall state of the second user as depicted in FIG. 8-4h. For instance, the events data acquisition module 8-102 of the computing device 8-10 acquiring data indicating at least one subjective observation made by the user 8-20* regarding a perceived subjective overall state of the second user (e.g., “he seems to be OK”).

In the same or different implementations, operation 8-444 may include an operation 8-448 for acquiring data indicating at least one subjective observation made by the user regarding an activity performed by the second user as depicted in FIG. 8-4h. For instance, the events data acquisition module 8-102 of the computing device 8-10 acquiring data indicating at least one subjective observation made by the user 8-20* regarding an activity performed by the second user (e.g., “she exercised vigorously this morning”). Note that such an activity could be related to the behavior, facial expression, or any other physical activities of the second user.

In various implementations, operation 8-436 may include an operation 8-449 for acquiring data indicating a second subjective observation as depicted in FIG. 8-4h. For instance, the events data acquisition module 8-102 of the computing device 8-10 acquiring data indicating a second subjective observation (e.g., as made by the user 8-20* or by a third party source 8-50 such as another user).

In some implementations, operation 8-449 may include an operation 8-450 for acquiring data indicating one subjective observation associated with a first point or interval in time and a second subjective observation associated with a second point or interval in time as depicted in FIG. 8-4h. For instance, the events data acquisition module 8-102 of the computing device 8-10 acquiring data indicating one subjective observation (e.g., he exercised vigorously this morning) associated with a first point or interval in time and a second subjective observation (e.g., he looks very alert today) associated with a second point or interval in time.

In some implementations, operation 8-449 may include an operation 8-451 for acquiring data indicating one subjective observation made by the user and data indicating a second subjective observation made by a second user as depicted in FIG. 8-4h. For instance, the events data acquisition module 8-102 of the computing device 8-10 acquiring data indicating one subjective observation (e.g., “the weather is nice today”) made by the user 8-20* and data indicating a second subjective observation (e.g., “the user appears to be happy today”) made by a second user (e.g., a third party source 8-50).

Referring back to the events data acquisition operation 8-302 of FIG. 8-3, in some implementations, the events data acquisition operation 8-302 may include an operation 8-452 for acquiring data indicating incidence of a first one or more reported events and data indicating incidence of a second one or more reported events that includes data indicating at least one subjective user state associated with the user and data indicating at least one objective occurrence as depicted in FIG. 8-4i. For instance, the events data acquisition module 8-102 of the computing device 8-10 acquiring data indicating incidence of a first one or more reported events 8-61* and data indicating incidence of a second one or more reported events 8-62* that includes data indicating at least one subjective user state (e.g., tension) associated with the user 8-20* and data indicating at least one objective occurrence (e.g., high blood pressure).

In some implementations, the events data acquisition operation 8-302 may include an operation 8-453 for acquiring data indicating incidence of a first one or more reported events and data indicating incidence of a second one or more reported events that includes data indicating at least one subjective user state associated with the user and data indicating at least one subjective observation as depicted in FIG. 8-4i. For instance, the events data acquisition module 8-102 of the computing device 8-10 acquiring data indicating incidence of a first one or more reported events 8-61* and data indicating incidence of a second one or more reported events 8-62* that includes data indicating at least one subjective user state (e.g., anxiety) associated with the user 8-20* and data indicating at least one subjective observation (e.g., “boss appears angry”).

In some implementations, the events data acquisition operation 8-302 may include an operation 8-454 for acquiring data indicating incidence of a first one or more reported events and data indicating incidence of a second one or more reported events that includes data indicating at least one objective occurrence and data indicating at least one subjective observation as depicted in FIG. 8-4i. For instance, the events data acquisition module 8-102 of the computing device 8-10 acquiring data indicating incidence of a first one or more reported events 8-61* and data indicating incidence of a second one or more reported events 8-62* that includes data indicating at least one objective occurrence (e.g., high blood pressure) and data indicating at least one subjective observation (e.g., “the stock market performed poorly today”).

In some implementations, the events data acquisition operation 8-302 may include an operation 8-455 for acquiring data indicating incidence of a first one or more reported events and data indicating incidence of a second one or more reported events that includes data indicating a first reported event associated with a first point or interval in time and data indicating a second reported event associated with a second point or interval in time as depicted in FIG. 8-4i. For instance, the events data acquisition module 8-102 of the computing device 8-10 acquiring data indicating incidence of a first one or more reported events 8-61* and data indicating incidence of a second one or more reported events 8-62* that includes data indicating a first reported event associated with a first point or interval in time (e.g., 9 AM to 10 AM) and data indicating a second reported event associated with a second point or interval in time (e.g., 11 AM to 3 PM).

In some implementations, the events data acquisition operation 8-302 may include an operation 8-456 for acquiring data indicating incidence of a third one or more reported events as depicted in FIG. 8-4i. For instance, the events data acquisition module 8-102 of the computing device 8-10 acquiring data indicating incidence of a third one or more reported events. For example, acquiring a third one or more reported events that may not be associated with or be relevant (e.g., “noise” data) to the hypothesis to be developed.

Referring back to FIG. 8-3, the events pattern determination operation 8-304 in various implementations may be performed in a number of different ways. For example, in some implementations, the events pattern determination operation 8-304 may include an operation 8-502 for determining the events pattern by excluding from the determination a third one or more reported events indicated by the events data as depicted in FIG. 8-5. For instance, the events pattern determination module 8-104 of the computing device 8-10 determining the events pattern by the exclusion module 8-208 (see FIG. 8-2b) excluding from the determination a third one or more reported events indicated by the events data 8-60*.

In various implementations, operation 8-502 may include an operation 8-504 for filtering the events data to filter out data indicating incidence of the third one or more reported events as depicted in FIG. 8-5. For instance, the filter module 8-210 (see FIG. 8-2b) of the computing device 8-10 filtering the events data 8-60* to filter out data indicating incidence of the third one or more reported events 8-63*.

Operation 8-504, in turn, may include one or more additional operations in various alternative implementations. For example, in some implementations, operation 8-504 may include an operation 8-506 for filtering the events data based, at least in part, on historical data identifying and linking at least two event types as depicted in FIG. 8-5. For instance, the filter module 8-210 of the computing device 8-10 filtering the events data 8-60* based, at least in part, on the historical data referencing module 8-212 (see FIG. 8-2b) referencing historical data 8-82 identifying and linking at least two event types (e.g., excessive consumption of food and upset stomach).

Operation 8-506, in various implementations, may further include an operation 8-508 for filtering the events data by filtering out data that indicates events that are not identified by the historical data as depicted in FIG. 8-5. For instance, the filter module 8-210 of the computing device 8-10 filtering the events data 8-60* by filtering out data that indicates events that are not identified by the historical data 8-82.

In some implementations, operation 8-504 may include an operation 8-510 for filtering the events data based, at least in part, on an existing hypothesis as depicted in FIG. 8-5. For instance, the filter module 8-210 of the computing device 8-10 filtering the events data 8-60* based, at least in part, on an existing hypothesis 8-80 referenced by the hypothesis referencing module 8-214.

Operation 8-510, in turn, may include one or more additional operations in various alternative implementations. For example, in some implementations, operation 8-510 may include an operation 8-512 for filtering the events data based, at least in part, on an existing hypothesis that is specific to the user as depicted in FIG. 8-5. For instance, the filter module 8-210 of the computing device 8-10 filtering the events data 8-60* based, at least in part, the hypothesis referencing module 8-214 referencing on an existing hypothesis 8-80 that is specific to the user 8-20*. For example, such an existing hypothesis 8-80 may have been initially created based on events data 8-60* that was specifically associated with the user 8-20*.

In some implementations, operation 8-510 may include an operation 8-514 for filtering the events data based, at least in part, on an existing hypothesis that is associated with at least a subgroup of a general population, the user included in the subgroup as depicted in FIG. 8-5. For instance, the filter module 8-210 of the computing device 8-10 filtering the events data 8-60* based, at least in part, on the hypothesis referencing module 8-214 referencing an existing hypothesis 8-80 that is associated with at least a subgroup of a general population, the user 8-20* included in the subgroup. For example, such an existing hypothesis 8-80 may be specifically related to a particular ethnic group.

Referring back to the events pattern determination operation 8-304 of FIG. 8-3, in some implementations, the events pattern determination operation 8-304 may include an operation 8-516 for determining a time or temporal sequential pattern based selectively on the incidences of the first one or more reported events and the second one or more reported events as depicted in FIG. 8-5. For instance, the events pattern determination module 8-104 of the computing device 8-10 determining a time or temporal sequential pattern based selectively on the incidences of the first one or more reported events and the second one or more reported events. The determination of the sequential pattern may involve the determination of the time or temporal relationship between at least a first event type (e.g., a subjective user state such as a hangover) and a second event type (e.g., an objective occurrence such as consumption of an alcoholic beverage).

In some implementations, the events pattern determination operation 8-304 may include an operation 8-518 for determining a spatial pattern based selectively on the incidences of the first one or more reported events and the second one or more reported events as depicted in FIG. 8-5. For instance, the events pattern determination module 8-104 of the computing device 8-10 determining a spatial pattern based selectively on the incidences of the first one or more reported events and the second one or more reported events. The determination of the spatial pattern may involve the determination of spatial relationships between at least a first event type (e.g., a subjective user state such as feeling happy at work) and a second event type (e.g., an objective occurrence such as the boss being away on vacation in Hawaii).

Referring back to the hypothesis development operation 8-306 of FIG. 8-3, in various implementations, the hypothesis development operation 8-306 may be executed in a number of different ways depending upon, for example, whether a hypothesis is being created or an existing hypothesis 8-80 is being further developed or revised. For example, in some implementations, the hypothesis development operation 8-306 may include a creation operation 8-602 for creating the hypothesis based, at least in part, on at least the first one or more reported events and the second one or more reported events and on historical data as depicted in FIG. 8-6a. For instance, the hypothesis creation module 8-216 (see FIG. 8-2c) of the computing device 8-10 creating the hypothesis based, at least in part, on at least the first one or more reported events and the second one or more reported events (e.g., as indicated by the event data 8-60*) and on historical data 8-82 (e.g., historical sequential or spatial events patterns associated with at least the user 8-20*) as referenced by, for example, the historical data referencing module 8-220.

In some implementations, the creation operation 8-602 may include an operation 8-604 for creating the hypothesis based, at least in part, on historical data that is particular to the user as depicted in FIG. 8-6a. For instance, the hypothesis creation module 8-216 of the computing device 8-10 creating the hypothesis based, at least in part, on historical data 8-82 (e.g., as referenced by the historical data referencing module 8-220) that is particular to the user 8-20*.

In some implementations, the creation operation 8-602 may include an operation 8-606 for creating the hypothesis based, at least in part, on historical data that is associated with at least a subgroup of a general population, the subgroup including the user as depicted in FIG. 8-6a. For instance, the hypothesis creation module 8-216 of the computing device 8-10 creating the hypothesis based, at least in part, on historical data 8-82 (e.g., as referenced by the historical data referencing module 8-220) that is associated with at least a subgroup of a general population, the subgroup including the user 8-20*.

The hypothesis development operation 8-306 of FIG. 8-3, in various implementations, may comprise one or more operations for updating or further developing of an existing hypothesis 8-80. For example, in some implementations, the hypothesis development operation 8-306 may include a determination operation 8-608 for determining whether the determined events pattern supports an existing hypothesis associated with the user as depicted in FIG. 8-6a. For instance, the determination module 8-222 (see FIG. 8-2c) of the computing device 8-10 determining whether an events pattern (e.g., as determined by the events pattern determination module 8-104) supports an existing hypothesis 8-80 associated with the user 8-20*.

In various implementations, the determination operation 8-608 may be executed in a number of different ways depending upon circumstances. For example, in various implementations, the determination operation 8-608 may include a comparison operation 8-610 for comparing the determined events pattern to an events pattern associated with the existing hypothesis to determine whether the determined events pattern supports the existing hypothesis as depicted in FIG. 8-6a. For instance, the comparison module 8-224 (e.g., see FIG. 8-2c) of the computing device 8-10 comparing the determined events pattern (e.g., as determined by the events pattern determination module 8-104) to an events pattern associated with the existing hypothesis 8-80 to determine whether the determined events pattern supports the existing hypothesis 8-80.

In some implementations, the comparison operation 8-610 may include an operation 8-612 for determining strength of the existing hypothesis associated with the user based, at least in part, on the comparison as depicted in FIG. 8-6a. For instance, the strength determination module 8-226 of the computing device 8-10 determining the strength of the existing hypothesis 8-80 associated with the user 8-20* based, at least in part, on the comparison. That is, by determining how similar the determined events pattern is to the events pattern associated with the existing hypothesis 8-80, a determination may be made as to the strength of the existing hypothesis 8-80. For example, suppose the existing hypothesis 8-80 relates to an alleged association or link between two event types. If the determined events pattern is similar or matches the events pattern associated with the existing hypothesis 8-80, then this may indicate a strong or stronger link between the two event types.

In some implementations, the comparison operation 8-610 may include an operation 8-616 for determining weakness of the existing hypothesis associated with the user based, at least in part, on the comparison as depicted in FIG. 8-6a. For instance, the weakness determination module 8-228 of the computing device 8-10 determining the weakness of the existing hypothesis 8-80 associated with the user 8-20* based, at least in part, on the comparison. That is, by determining how different the determined events pattern is to the events pattern associated with the existing hypothesis 8-80, a determination may be made as to the weakness of the existing hypothesis 8-80. For example, suppose the existing hypothesis 8-80 relates to an alleged association or link between two event types. If the determined events pattern is determined to be dissimilar to the events pattern associated with the existing hypothesis 8-80, then this may indicate a weak or weaker link between the two event types.

In various implementations, the determination operation 8-608 may include an operation 8-618 for determining whether the determined events pattern supports an existing hypothesis that links a first event type with a second event type as depicted in FIG. 8-6a. For instance, the determination module 8-222 of the computing device 8-10 determining whether the determined events pattern (e.g., as determined by the events pattern determination module 8-104 of FIG. 8-2b and referenced by the determined events pattern referencing module 8-230 of FIG. 8-2c) supports an existing hypothesis 8-80 that links a first event type (e.g., a subjective mental state such as drowsiness) with a second event type (e.g., consumption of a medicine such as cold medication).

In some implementations, operation 8-618 may include an operation 8-620 for determining whether the determined events pattern supports an existing hypothesis that time or temporally links a first event type with a second event type as depicted in FIG. 8-6a. For instance, the determination module 8-222 of the computing device 8-10 determining whether the determined events pattern (e.g., as determined by the events pattern determination module 8-104 and referenced by the determined events pattern referencing module 8-230) supports an existing hypothesis 8-80 that sequentially (e.g., time or temporally) links a first event type (e.g., a hangover) with a second event type (e.g., binge drinking)

In some implementations, operation 8-618 may include an operation 8-622 for determining whether the determined events pattern supports an existing hypothesis that spatially links a first event type with a second event type as depicted in FIG. 8-6a. For instance, the determination module 8-222 of the computing device 8-10 determining whether the determined events pattern (e.g., as determined by the events pattern determination module 8-104 and referenced by the determined events pattern referencing module 8-230) supports an existing hypothesis 8-80 that spatially links a first event type (e.g., in-laws visiting home) with a second event type (e.g., feeling tension at home).

In various implementations, the hypothesis development operation 8-306 of FIG. 8-3 may include an operation 8-624 for developing a hypothesis that links a first subjective user state type with a second subjective user state type based, at least in part, on the determined events pattern as depicted in FIG. 8-6b. For instance, the hypothesis development module 8-106 of the computing device 8-10 developing a hypothesis that links a first subjective user state type (e.g., tension) with a second subjective user state type (e.g., upset stomach) based, at least in part, on the determined events pattern (e.g., as determined by the events pattern determination module 8-104 and referenced by the determined events pattern referencing module 8-230).

In some implementations, the hypothesis development operation 8-306 may include an operation 8-626 for developing a hypothesis that links a first objective occurrence type with a second objective occurrence type based, at least in part, on the determined events pattern as depicted in FIG. 8-6b. For instance, the hypothesis development module 8-106 of the computing device 8-10 developing a hypothesis that links a first objective occurrence type (e.g., consuming a particular type of food item) with a second objective occurrence type (e.g., increased bowel movement) based, at least in part, on the determined events pattern (e.g., as determined by the events pattern determination module 8-104 and referenced by the determined events pattern referencing module 8-230).

In some implementations, the hypothesis development operation 8-306 may include an operation 8-628 for developing a hypothesis that links a first subjective observation type with a second subjective observation type based, at least in part, on the determined events pattern as depicted in FIG. 8-6b. For instance, the hypothesis development module 8-106 of the computing device 8-10 developing a hypothesis that links a first subjective observation type (e.g., good weather) with a second subjective observation type (e.g., sulking behavior) based, at least in part, on the determined events pattern (e.g., as determined by the events pattern determination module 8-104 and referenced by the determined events pattern referencing module 8-230).

In some implementations, the hypothesis development operation 8-306 may include an operation 8-630 for developing a hypothesis that associates one or more subjective user state types with one or more objective occurrence types based, at least in part, on the determined events pattern as depicted in FIG. 8-6b. For instance, the hypothesis development module 8-106 of the computing device 8-10 developing a hypothesis that associates one or more subjective user state types (e.g., happiness) with one or more objective occurrence types (e.g., spending time with children) based, at least in part, on the determined events pattern (e.g., as determined by the events pattern determination module 8-104 and referenced by the determined events pattern referencing module 8-230).

In some implementations, the hypothesis development operation 8-306 may include an operation 8-632 for developing a hypothesis that associates one or more subjective user state types with one or more subjective observation types based, at least in part, on the determined events pattern as depicted in FIG. 8-6b. For instance, the hypothesis development module 8-106 of the computing device 8-10 developing a hypothesis that associates one or more subjective user state types (e.g., depression) with one or more subjective observation types (e.g., sluggish appearance) based, at least in part, on the determined events pattern (e.g., as determined by the events pattern determination module 8-104 and referenced by the determined events pattern referencing module 8-230).

In some implementations, the hypothesis development operation 8-306 may include an operation 8-634 for developing a hypothesis that associates one or more objective occurrence types with one or more subjective observation types based, at least in part, on the determined events pattern as depicted in FIG. 8-6b. For instance, the hypothesis development module 8-106 of the computing device 8-10 developing a hypothesis that associates one or more objective occurrence types (e.g., high blood pressure) with one or more subjective observation types (e.g., intense appearance) based, at least in part, on the determined events pattern (e.g., as determined by the events pattern determination module 8-104 and referenced by the determined events pattern referencing module 8-230).

Referring now to FIG. 8-7 illustrating another operational flow 8-700 in accordance with various embodiments. In some embodiments, operational flow 8-700 may be particularly suited to be performed by the computing device 8-10, which may be a network server or a standalone computing device. Operational flow 8-700 includes operations that mirror the operations included in the operational flow 8-300 of FIG. 8-3. For example, operational flow 8-700 may include an events data acquisition operation 8-702, an events pattern determination operation 8-704, and a hypothesis development operation 8-706 that corresponds to and mirror the events data acquisition operation 8-302, the events pattern determination operation 8-304, and the hypothesis development operation 8-706, respectively, of FIG. 8-3.

In addition, and unlike operational flow 8-300, operational flow 8-700 may further include an action execution operation 8-708 for executing one or more actions in response to the developing as depicted in FIG. 8-7. For instance, the action execution module 8-108 of the computing device 8-10 executing one or more actions (e.g., presenting results of the hypothesis development, initiating monitoring operations for particular event types, and so forth) in response to a hypothesis development operation 8-706 performed by, for example, the hypothesis development module 8-106.

In various implementations, the action execution operation 8-708 may be performed in a number of different ways depending upon the particular circumstances. For example, in some implementations, the action execution operation 8-708 may include a presentation operation 8-802 for presenting one or more results of the developing as depicted in FIG. 8-8a. For instance, the presentation module 8-232 (see FIG. 8-2d) of the computing device 8-10 presenting (e.g., transmitting via a network interface 8-120 or indicating via a user interface 8-122) one or more results 8-90 (e.g., an advisory related to the hypothesis) of the developing of the hypothesis as performed in the hypothesis development operation 8-706.

In various implementations, the presentation operation 8-802 may include one or more additional operations. For example, in some implementations, the presentation operation 8-802 may include an operation 8-804 for transmitting the one or more results of the developing via at least one of a wireless network and a wired network as depicted in FIG. 8-8a. For instance, the transmission module 8-234 of the computing device 8-10 transmitting (e.g., via network interface 8-120) the one or more results of the developing via a wireless and/or a wired network 8-40.

In some implementations, the presentation operation 8-802 may include an operation 8-806 for transmitting the one or more results to the user as depicted in FIG. 8-8a. For instance, the transmission module 8-234 of the computing device 8-10 transmitting the one or more results 8-90 to the user 8-20a.

In some implementations, the presentation operation 8-802 may include an operation 8-808 for transmitting the one or more results to one or more third parties as depicted in FIG. 8-8a. For instance, the transmission module 8-234 of the computing device 8-10 transmitting the one or more results 8-90 to one or more third parties (e.g., one or more third party sources 8-50).

In some implementations, the presentation operation 8-802 may include an operation 8-810 for indicating the one or more results via a user interface as depicted in FIG. 8-8a. For instance, the indication module 8-236 of the computing device 8-10 indicating the one or more results 8-90 via a user interface 8-122 (e.g., a display monitor, a touchscreen, a speaker, and so forth).

In some implementations, the presentation operation 8-802 may include an operation 8-812 for presenting the hypothesis as depicted in FIG. 8-8a. For instance, the hypothesis presentation module 8-238 of the computing device 8-10 presenting (e.g., transmitting or indicating) the hypothesis.

In some implementations, the presentation operation 8-802 may include an operation 8-814 for presenting an indication of a confirmation of the hypothesis as depicted in FIG. 8-8a. For instance, the hypothesis confirmation presentation module 8-240 of the computing device 8-10 presenting (e.g., via a network interface 8-120 or via a user interface 8-122) an indication of a confirmation of the hypothesis.

In some implementations, the presentation operation 8-802 may include an operation 8-816 for presenting an indication of soundness or weakness of the hypothesis as depicted in FIG. 8-8a. For instance, the hypothesis soundness/weakness presentation module 8-242 of the computing device 8-10 presenting (e.g., via a network interface 8-120 or via a user interface 8-122) an indication of soundness or weakness of the hypothesis.

In some implementations, the presentation operation 8-802 may include an operation 8-818 for presenting an advisory of one or more past events as depicted in FIG. 8-8a. For instance, the advisory presentation module 8-244 of the computing device 8-10 presenting an advisory (e.g., notification regarding a pattern of reported events such as “did you know that the last time you drank four mugs of beer, you had a hangover the next day”).

In some implementations, the presentation operation 8-802 may include an operation 8-820 for presenting a recommendation for a future action as depicted in FIG. 8-8a. For instance, the recommendation presentation module 8-246 of the computing device 8-10 presenting a recommendation for a future action (e.g., “since you drank four mugs of beer last night, you should take two tablets of aspirin before you go to work in the morning”).

In various implementations, the action execution operation 8-708 of FIG. 8-7 may include a monitoring operation 8-822 for monitoring of reported events as depicted in FIG. 8-8b. For instance, the monitoring module 8-250 of the computing device 8-10 monitoring of reported events (e.g., as reported by the user 8-20*, by one or more third party sources 8-50, or by one or more remote network devices such as sensors 8-35 or network servers 8-36).

In some implementations, the monitoring operation 8-822 may include an operation 8-824 for monitoring of reported events to determine whether the reported events include events identified by the hypothesis as depicted in FIG. 8-8b. For instance, the monitoring module 8-250 of the computing device 8-10 monitoring of reported events (e.g., reported via one or more blog entries, one or more status reports, one or more electronic messages, and so forth) to determine whether the reported events include events identified by the hypothesis.

In some implementations, the monitoring operation 8-822 may include an operation 8-826 for monitoring of reported events being reported by the user as depicted in FIG. 8-8b. For instance, the monitoring module 8-250 of the computing device 8-10 monitoring of reported events (e.g., reported via one or more blog entries, one or more status reports, one or more electronic messages, and so forth) being reported by the user 8-20*.

In some implementations, the monitoring operation 8-822 may include an operation 8-828 for monitoring of reported events being reported by one or more remote network devices as depicted in FIG. 8-8b. For instance, the monitoring module 8-250 of the computing device 8-10 monitoring of reported events (e.g., events reported via wireless and/or wired network 8-40) being reported by one or more remote network devices (e.g., sensors 8-35 and/or network servers 8-36).

In some implementations, the monitoring operation 8-822 may include an operation 8-830 for monitoring of reported events being reported by one or more third party sources as depicted in FIG. 8-8b. For instance, the monitoring module 8-250 of the computing device 8-10 monitoring of reported events (e.g., events reported via wireless and/or wired network 8-40) being reported by one or more third party sources 8-50.

### X: Hypothesis Selection and Presentation of One or More Advisories

In the following detailed description, reference is made to the accompanying drawings, which form a part hereof. In the drawings, similar symbols typically identify similar components, unless context dictates otherwise. The illustrative embodiments described in the detailed description, drawings, and claims are not meant to be limiting. Other embodiments may be utilized, and other changes may be made, without departing from the spirit or scope of the subject matter presented here.

A recent trend that is becoming increasingly popular in the computing/communication field is to electronically record one's feelings, thoughts, and other aspects of the person's everyday life onto an open diary. One place where such open diaries are maintained are at social networking sites commonly known as “blogs” where users may report or post their latest status, personal activities, and various other aspects of the users' everyday life. The process of reporting or posting blog entries is commonly referred to as blogging. Other social networking sites may allow users to update their personal information via, for example, social networking status reports in which a user may report or post for others to view their current status, activities, and/or other aspects of the user.

A more recent development in social networking is the introduction and explosive growth of microblogs in which individuals or users (referred to as “microbloggers”) maintain open diaries at microblog websites (e.g., otherwise known as “twitters”) by continuously or semi-continuously posting microblog entries. A microblog entry (e.g., “tweet”) is typically a short text message that is usually not more than 140 characters long. The microblog entries posted by a microblogger may report on any aspect of the microblogger's daily life. Typically, such microblog entries will describe the various “events” associated with or are of interest to the microblogger that occurs during a course of a typical day. The microblog entries are often continuously posted during the course of a typical day, and thus, by the end of a normal day, a substantial number of events may have been reported and posted.

Each of the reported events that may be posted through microblog entries may be categorized into one of at least three possible categories. The first category of events that may be reported through microblog entries are “objective occurrences” that may or may not be associated with the microblogger. Objective occurrences that are associated with a microblogger may be any characteristic, incident, happening, or any other event that occurs with respect to the microblogger or are of interest to the microblogger that can be objectively reported by the microblogger, a third party, or by a device. Such events would include, for example, intake of food, medicine, or nutraceutical, certain physical characteristics of the microblogger such as blood sugar level or blood pressure that can be objectively measured, activities of the microblogger observable by others or by a device, activities of others that may or may not be of interest to the microblogger, external events such as performance of the stock market (which the microblogger may have an interest in), performance of a favorite sports team, and so forth. In some cases, objective occurrences may not be at least directly associated with a microblogger. Examples of such objective occurrences include, for example, external events that may not be directly related to the microblogger such as the local weather, activities of others (e.g., spouse or boss) that may directly or indirectly affect the microblogger, and so forth.

A second category of events that may be reported or posted through microblog entries include “subjective user states” of the microblogger. Subjective user states of a microblogger may include any subjective state or status associated with the microblogger that can only be typically reported by the microblogger (e.g., generally cannot be directly reported by a third party or by a device). Such states including, for example, the subjective mental state of the microblogger (e.g., happiness, sadness, anger, tension, state of alertness, state of mental fatigue, jealousy, envy, and so forth), the subjective physical state of the microblogger (e.g., upset stomach, state of vision, state of hearing, pain, and so forth), and the subjective overall state of the microblogger (e.g., “good,” “bad,” state of overall wellness, overall fatigue, and so forth). Note that the term “subjective overall state” as will be used herein refers to those subjective states that may not fit neatly into the other two categories of subjective user states described above (e.g., subjective mental states and subjective physical states).

A third category of events that may be reported or posted through microblog entries include “subjective observations” made by the microblogger. A subjective observation is similar to subjective user states and may be any subjective opinion, thought, or evaluation relating to any external incidence. Thus, the difference between subjective user states and subjective observations is that subjective user states relates to self-described subjective descriptions of the user states of one's self while subjective observations relates to subjective descriptions or opinions regarding external events. Examples of subjective observations include, for example, a microblogger's perception about the subjective user state of another person (e.g., “he seems tired”), a microblogger's perception about another person's activities (e.g., “he drank too much yesterday”), a microblogger's perception about an external event (e.g., “it was a nice day today”), and so forth. Although microblogs are being used to provide a wealth of personal information, thus far they have been primarily limited to their use as a means for providing commentaries and for maintaining open diaries.

In accordance with various embodiments, methods, systems, and computer program products are provided to, among other things, select a hypothesis from a plurality of hypotheses based on at least one reported event associated with a user, the selected hypothesis being a hypothesis that may link together (e.g., correlate) a plurality of different types of events (i.e., event types). In some embodiments, the selected hypothesis (as well as, in some cases, the plurality of hypotheses) may be relevant to the user. After making the selection, the methods, systems, and computer program products may present one or more advisories related to the selected hypothesis. The methods, systems, and computer program products may be employed in a variety of environments including, for example, social networking environments, blogging or microblogging environments, instant messaging (IM) environments, or any other type of environment that allows a user to, for example, maintain a diary.

In various implementations, a “hypothesis,” as referred to herein, may define one or more relationships or links between different types of events (i.e., event types) including at least a first event type (e.g., a type of event such as a particular type of subjective user state, for example, an emotional state such as “happy”) and a second event type (e.g., another type of event such as particular type of objective occurrence, for example, favorite sports team winning a game). In some cases, a hypothesis may be represented by an events pattern that may indicate spatial or sequential relationships between different event types (e.g., different types of events such as subjective user states and objective occurrences). Note that for ease of explanation and illustration, the following description will describe a hypothesis as defining, for example, the sequential or spatial relationship between two different event types, a first event type and a second event type. However, those skilled in the art will recognize that such a hypothesis could also identify the relationships between three or more event types (e.g., a first event type, a second event type, a third event type, and so forth).

In some embodiments, a hypothesis may, at least in part, be defined or represented by an events pattern that indicates or suggests a spatial or a sequential (e.g., time/temporal) relationship between different event types. Such a hypothesis, in some cases, may also indicate the strength or weakness of the link between the different event types. That is, the strength or weakness (e.g., soundness) of the correlation between different event types may depend upon, for example, whether the events pattern repeatedly occurs and/or whether a contrasting events pattern has occurred that may contradict the hypothesis and therefore, weaken the hypothesis (e.g., an events pattern that indicates a person becoming tired after jogging for thirty minutes when a hypothesis suggests that a person will be energized after jogging for thirty minutes).

As briefly described above, a hypothesis may be represented by an events pattern that may indicate spatial or sequential (e.g., time or temporal) relationship or relationships between multiple event types. In some implementations, a hypothesis may merely indicate temporal sequential relationships between multiple event types that indicate the temporal relationships between multiple event types. In alternative implementations a hypothesis may indicate a more specific time relationship between multiple event types. For example, a sequential pattern may represent the specific pattern of events that occurs along a timeline that may indicate the specific time intervals between event types. In still other implementations, a hypothesis may indicate the spatial (e.g., geographical) relationships between multiple event types.

In various embodiments, the development of a hypothesis may be particularly useful to a user (e.g., a microblogger or a social networking user) that the hypothesis may be associated with. That is, in some instances a hypothesis may be developed for a user that may assist the user in modifying his/her future behavior, while in other instances such a hypothesis may simply alert or notify the user that a pattern of events are repeatedly occurring. In other situations, such a hypothesis may be useful to third parties such as advertisers in order to assist the advertisers in developing a more targeted marketing scheme. In still other situations, such a hypothesis may help in the treatment of ailments associated with the user.

One way to develop a hypothesis (e.g., creation of and/or further development of a hypothesis) is to determine a pattern of reported events that repeatedly occurs with respect to a particular user and/or to compare similar or dissimilar reported pattern of events that occurs with respect to a user. For example, if a user such as a microblogger reports repeatedly that after each visit to a particular restaurant, the user always has an upset stomach, then a hypothesis may be created and developed that suggests that the user will get an upset stomach after visiting the particular restaurant. If, on the other hand, after developing such a hypothesis, the user reports that the last time he ate at the restaurant, he did not get an upset stomach, then such a report may result in the weakening of the hypothesis. Alternatively, if after developing such a hypothesis, the user reports that the last time he ate at the restaurant, he again got an upset stomach, then such a report may result in a confirmation of the soundness of the hypothesis. Note that the soundness of a hypothesis (e.g., strength or weakness of the hypothesis) may depend upon how much the historical data supports such a hypothesis.

Numerous hypotheses may be developed and may be associated with a particular user. For example, in the case of a microblogger, given the amount of “events data” (and the large amounts of reported events indicated by the events data) that may be provided by the microblogger via microblog entries, a large number of hypotheses associated with the microblogger may eventually be developed based on the reported events indicated by the events data. Alternatively, hypotheses may also be provided by one or more third party sources. For example, a number of hypotheses may be provided by other users or by one or more network service providers.

Thus, in accordance with various embodiments, methods, systems, and computer program products are provided to, among other things, select a hypothesis from a plurality of hypotheses that may be associated with a particular user (e.g., a microblogger), where the selected hypothesis may link or correlate a plurality of different types of events (i.e., event types). After making the selection, the methods, systems, and computer program products may present one or more advisories related to the selected hypothesis.

FIGS. 9-1a and 9-1b illustrate an example environment in accordance with various embodiments. In the illustrated environment, an exemplary system 9-100 may include at least a computing device 9-10 (see FIG. 9-1b). The computing device 9-10, which may be a server (e.g., network server) or a standalone device, may be employed in order to, among other things, acquire events data 9-60* that may indicate one or more reported events. For example, the events data 9-60* to be acquired may include data indicating at least one reported event 9-61*, data indicating at least a second reported event 9-62*, and so forth. Based on the one or more reported events indicated by the acquired events data 9-60*, the computing device 9-10 may then be configured to select at least one hypothesis 9-81* from a plurality of hypotheses 9-80. After selecting the at least one hypothesis 9-81*, the computing device 9-10 may be configured to present one or more advisories 9-90 related to the at least one hypothesis 9-81*.

As indicated earlier, in some embodiments, the computing device 9-10 may be a server while in other embodiments the computing device 9-10 may be a standalone device. In the case where the computing device 9-10 is a network server, the computing device 9-10 may communicate indirectly with a user 9-20a via wireless and/or wired network 9-40. In contrast, in embodiments where the computing device 9-10 is a standalone device, it may communicate directly with a user 9-20b via a user interface 9-122 (see FIG. 9-1b). In the following, “*” indicates a wildcard. Thus, references to user 9-20* may indicate a user 9-20a or a user 9-20b of FIGS. 9-1a and 9-1b.

In embodiments in which the computing device 9-10 is a network server, the computing device 9-10 may communicate with a user 9-20a via a mobile device 9-30 and through a wireless and/or wired network 9-40. A network server, as will be described herein, may be in reference to a server located at a single network site or located across multiple network sites or a conglomeration of servers located at multiple network sites. The mobile device 9-30 may be a variety of computing/communication devices including, for example, a cellular phone, a personal digital assistant (PDA), a laptop, a desktop, or other types of computing/communication devices that can communicate with the computing device 9-10. In some embodiments, the mobile device 9-30 may be a handheld device such as a cellular telephone, a smartphone, a Mobile Internet Device (MID), an Ultra Mobile Personal Computer (UMPC), a convergent device such as a personal digital assistant (PDA), and so forth.

In embodiments in which the computing device 9-10 is a standalone computing device 9-10 (or simply “standalone device”) that communicates directly with a user 9-20b, the computing device 9-10 may be any type of portable device (e.g., a handheld device) or stationary device (e.g., desktop computer or workstation). For these embodiments, the computing device 9-10 may be a variety of computing/communication devices including, for example, a cellular phone, a personal digital assistant (PDA), a laptop, a desktop, or other types of computing/communication devices. In some embodiments, in which the computing device 9-10 is a handheld device, the computing device 9-10 may be a cellular telephone, a smartphone, an MID, an UMPC, a convergent device such as a PDA, and so forth. In various embodiments, the computing device 9-10 may be a peer-to-peer network component device. In some embodiments, the computing device 9-10 and/or the mobile device 9-30 may operate via a Web 2.0 construct (e.g., Web 2.0 application 9-268).

In various embodiments, the computing device 9-10 may be configured to acquire events data 9-60* from one or more sources. Events data 9-60*, as will be described herein, may indicate the occurrences of one or more reported events. Each of the reported events indicated by the events data 9-60* may or may not be associated with a user 9-20*. In some embodiments, a reported event may be associated with the user 9-20* if it is reported by the user 9-20* or it is related to some aspect about the user 9-20* (e.g., the location of the user 9-20*, the local weather of the user 9-20*, activities performed by the user 9-20*, physical characteristics of the user 9-20* as detected by a sensor 9-35, subjective user state of the user 9-20*, and so forth). At least three different types of reported events may be indicated by the events data 9-60*, subjective user states associated with a user 9-20*, objective occurrences, and subjective observations made by the user 9-20* or by others (e.g., one or more third parties 9-50).

The events data 9-60* that may be acquired by the computing device 9-10 may include at least data indicating at least one reported event 9-61* and/or data indicating at least a second reported event 9-62*. Though not depicted, the events data 9-60* may further include data indicating incidences of a third reported event, a fourth reported event, and so forth (as indicated by the dots). The events data 9-60* including the data indicating at least one reported event 9-61* and/or the data indicating at least a second reported event 9-62* may be obtained from one or more distinct sources (e.g., the original sources for the data). For example, in some implementations, a user 9-20* may provide at least a portion of the events data 9-60* (e.g., events data 9-60a that may include the data indicating at least one reported event 9-61a and/or the data indicating at least a second reported event 9-62a).

In the same or different embodiments, one or more remote network devices including one or more sensors 9-35 and/or one or more network servers 9-36 may provide at least a portion of the events data 9-60* (e.g., events data 9-60b that may include the data indicating at least one reported event 9-61b and/or the data indicating at least a second reported event 9-62b). In same or different embodiments, one or more third party sources may provide at least a portion of the events data 9-60* (e.g., events data 9-60c that may include the data indicating at least one reported event 9-61c and/or the data indicating at least a second reported event 9-62c). In still other embodiments, at least a portion of the events data 9-60* may be retrieved from a memory 9-140 in the form of historical data. Thus, to summarize, each of the data indicating at least one reported event 9-61* and the data indicating at least a second reported event 9-62* may be obtained from the same or different sources.

The one or more sensors 9-35 illustrated in FIG. 9-1a may represent a wide range of devices that can monitor various aspects or events associated with a user 9-20a (or user 9-20b). For example, in some implementations, the one or more sensors 9-35 may include devices that can monitor the user's physiological characteristics such as blood pressure sensors, heart rate monitors, glucometers, and so forth. In some implementations, the one or more sensors 9-35 may include devices that can monitor activities of a user 9-20* such as a pedometer, a toilet monitoring system (e.g., to monitor bowel movements), exercise machine sensors, an accelerometer to measure a person's movements which may indicate specific activities, and so forth. The one or more sensors 9-35 may also include other types of sensor/monitoring devices such as video or digital camera, global positioning system (GPS) to provide data that may be related to a user 9-20* (e.g., locations of the user 9-20*), and so forth.

The one or more third parties 9-50 illustrated in FIG. 9-1a may represent a wide range of third parties and/or the network devices associated with such parties. Examples of third parties include, for example, other users (e.g., other microbloggers or other social networking site users), health care entities (e.g., dental or medical clinic, hospital, physician's office, medical lab, and so forth), content providers, businesses such as retail business, employers, athletic or social groups, educational entities such as colleges and universities, and so forth.

In brief, after acquiring the events data 9-60* including data indicating at least one reported event 9-61* and/or data indicating at least a second reported event 9-62* from one or more sources, the computing device 9-10 may be designed to select at least one hypothesis 9-81* from a plurality of hypotheses 9-80 based, at least in part, on at least one reported event associated with a user 9-20*. In some cases, the selected hypothesis 9-81* as well as the plurality of hypotheses 9-80 may be relevant to the user 9-20*. In various embodiments, each of the plurality of hypotheses 9-80 may have been created and/or may have been at least initially provided (e.g., pre-installed) by a third party (e.g., network service providers, computing device manufacturer, and so forth) and/or may have been further refined by the computing device 9-10.

After selecting the at least one hypothesis 9-81*, the computing device 9-10 may be designed to execute one or more actions. One such action that may be executed is to present one or more advisories 9-90 associated with the at least one hypothesis 9-81* that was selected. For example, the computing device 9-10 may present the one or more advisories 9-90 to a user 9-20* (e.g., by transmitting the one or more advisories 9-90 to a user 9-20a or indicating the one or more advisories 9-90 to a user 9-20b via a user interface 9-122), to one or more third parties 9-50, and/or to one or more remote network devices (e.g., network servers 9-36). The one or more advisories 9-90 to be presented may include at least a presentation of the selected hypothesis 9-81*, an alert regarding past events related to the hypothesis 9-81* (e.g., past events that the hypothesis 9-81* may have been based on), a recommendation for a future action based on the selected hypothesis 9-81*, a prediction of an occurrence of a future event based on the selected hypothesis 9-81*, or other types of advisories.

As illustrated in FIG. 9-1b, computing device 9-10 may include one or more components and/or sub-modules. As those skilled in the art will recognize, these components and sub-modules may be implemented by employing hardware (e.g., in the form of circuitry such as application specific integrated circuit or ASIC, field programmable gate array or FPGA, or other types of circuitry), software, a combination of both hardware and software, or a general purpose computing device executing instructions included in a signal-bearing medium. In various embodiments, computing device 9-10 may include an events data acquisition module 9-102, a hypothesis selection module 9-104, a presentation module 9-106, a hypothesis development module 9-108, a network interface 9-120 (e.g., network interface card or NIC), a user interface 9-122 (e.g., a display monitor, a touchscreen, a keypad or keyboard, a mouse, an audio system including a microphone and/or speakers, an image capturing system including digital and/or video camera, and/or other types of interface devices), one or more applications 9-126 (e.g., a web 2.0 application 9-268, one or more communication applications 9-267 including, for example, a voice recognition application, and/or other applications), and/or memory 9-140, which may include a plurality of hypothesis 9-80. Note that although not depicted, one or more copies of the one or more applications 9-126 may be included in memory 9-140.

The events data acquisition module 9-102 may be configured to, among other things, acquire events data 9-60* from one or more distinct sources (e.g., from a user 9-20*, from one or more third parties 9-50, from one or more network devices such as one or more sensors 9-35 and/or one or more network servers 9-36, from memory 9-140 and/or from other sources). The events data 9-60* to be acquired by the events data acquisition module 9-102 may include one, or both, of data indicating at least one reported event 9-61* and data indicating at least a second reported event 9-62*. Each of the data indicating at least one reported event 9-61* and the data indicating at least a second reported event 9-62* may be acquired from the same source or different sources. The events data acquisition module 9-102 may also be designed to acquire additional data indicating a third reported event, a fourth reported event, and so forth. The events data 9-60* may be acquired in the form of one or more electronic entries such as blog (e.g., microblog) entries, status report entries, electronic message entries, diary entries, and so forth.

Referring now to FIG. 9-2a illustrating particular implementations of the events data acquisition module 9-102 of the computing device 9-10 of FIG. 9-1b. The events data acquisition module 9-102 may include a reception module 9-202 for receiving events data 9-60* including at least one of the data indicating at least one reported event 9-61* and the data indicating at least a second reported event 9-62*. The reception module 9-202 may further include a user interface reception module 9-204 and/or a network interface reception module 9-206. The user interface reception module 9-204 may be configured to receive, via a user interface 9-122, the events data 9-60* including at least one of the data indicating at least one reported event 9-61* and the data indicating at least a second reported event 9-62*. In contrast, the network interface reception module 9-206 may be configured to receive (e.g., via network interface 9-120) from a wireless and/or wired network 9-40 the events data 9-60* including at least one of the data indicating at least one reported event 9-61* and the data indicating at least a second reported event 9-62*. The reception module 9-202 may be designed to receive the events data 9-60* including the data indicating at least one reported event 9-61* and/or the data indicating at least a second reported event 9-62* in various forms and from various sources. For example, the events data 9-60* may be in the form of electronic entries such as blog entries (e.g., microblog entries), status report entries, and electronic messages. In various implementations, such entries may have originated from a user 9-20*, one or more third parties 9-50*, or one or more remote network devices (e.g., sensors 9-35 or network servers 9-36).

The hypothesis selection module 9-104 of the computing device 9-10 of FIG. 9-1b may be configured to, among other things, select a hypothesis 9-81* from a plurality of hypotheses 9-80 that may be relevant to a user 9-20*, the selection of the hypothesis 9-81* being based, at least in part, on at least one reported event associated with the user 9-20* (e.g., at least one reported event that is about or related to the user 9-20*, that may have been reported by the user 9-20*, or that may be of interest to the user 9-20*). FIG. 9-2b illustrates particular implementations of the hypothesis selection module 9-104 of FIG. 9-1b. As illustrated, the hypothesis selection module 9-104 may include a reported event referencing module 9-208 and/or a comparison module 9-210 that may further include a matching module 9-212, a contrasting module 9-214, and/or a relationship determination module 9-216 (that may further include a sequential link determination module 9-218 and/or a spatial link determination module 9-220). In various implementations, these sub-modules may be employed in order to facilitate the hypothesis selection module 9-104 in selecting the at least one hypothesis 9-81*.

In brief, the reported event referencing module 9-208 may be designed to reference one or more reported events that may have been indicated by the events data 9-60* acquired by the events data acquisition module 9-102. The referencing of the one or more reported events may facilitate the hypothesis selection module 9-104 in the selection of the at least one hypothesis 9-81*. In contrast, the comparison module 9-210 may be configured to compare the at least one reported event (e.g., as referenced by the reported event referencing module 9-208) to one, or both, of at least a first event type and a second event type that may be linked together by the at least one hypothesis 9-81*.

The matching module 9-212 may be configured to determine whether the at least one reported event at least substantially matches with the first event type and/or the second event type that may be indicated by the at least one hypothesis 9-81*. On the other hand, the contrasting module 9-214 may be configured to determine whether a second reported event (e.g., as indicated by the acquired events data 9-60*) is a contrasting event from the at least first event type and/or the second event type that may be indicated by the at least one hypothesis 9-81*.

The relationship determination module 9-216 may be configured to determine a relationship between a first reported event and a second reported event (e.g., as indicated by the acquired events data 9-60*). The sequential link determination module 9-218 may facilitate the relationship determination module 9-216 to determine a relationship between the first reported event and the second reported event by determining a sequential link (e.g., a temporal or a more specific time relationship) between the first reported event and the second reported event. The spatial link determination module 9-220 may facilitate the relationship determination module 9-216 to determine a relationship between the first reported event and the second reported event by determining a spatial link (e.g., a geographical relationship) between the first reported event and the second reported event.

FIG. 9-2c illustrates particular implementations of the presentation module 9-106 of FIG. 9-1b. In various implementations, the presentation module 9-106 may be configured to, among other things, present one or more advisories 9-90 related to the at least one hypothesis 9-81* selected by the hypothesis selection module 9-104. The presentation module 9-106, in various implementations, may include one or more sub-modules that may facilitate the presentation of the one or more advisories 9-90. For example, and as illustrated, the presentation module 9-106 may include an indication module 9-222 configured to indicate one or more advisories 9-90 related to the at least one hypothesis 9-81* selected by the hypothesis selection module 9-104. The presentation module 9-106 may also include a transmission module 9-224 configured to transmit one or more advisories 9-90 related to the at least one hypothesis 9-81* selected by the hypothesis selection module 9-104 via, for example, at least one of a wireless network or a wired network 9-40.

In various implementations, the presentation module 9-106 may include a hypothesis presentation module 9-226 configured to present (e.g., transmit via a wireless and/or wired network 9-40 or indicate via a user interface 9-122) at least one form of the at least one hypothesis 9-81* selected by the hypothesis selection module 9-104. The at least one hypothesis 9-81* may be presented in a number of different formats. For example, the hypothesis 9-81* may be presented in a graphical or iconic form, in audio form, or in textual form. Further, with respect to presenting the at least one hypothesis 9-81* in textual form, the hypothesis 9-81* may be presented in many different ways as there may be many different ways to describe a hypothesis 9-81* (this is also true when the hypothesis 9-81* is presented graphically or audibly). The hypothesis presentation module 9-226, in various implementations, may further include an event types relationship presentation module 9-228 that is configured to present an indication of a relationship (e.g., spatial or sequential relationship) between at least a first event type and at least a second event type as referenced by the at least one hypothesis 9-81* selected by the hypothesis selection module 9-104.

In various implementations, the event types relationship presentation module 9-228 may further include a soundness presentation module 9-230 configured to present an indication of the soundness of the at least hypothesis 9-81* selected by the hypothesis selection module 9-104. In some implementations, the soundness presentation module 9-230 may further include a strength/weakness presentation module 9-232 configured to present an indication of strength or weakness of correlation between the at least first event type and the at least second event type that may be linked together by the at least one hypothesis 9-81*, the at least one hypothesis 9-81* being selected by the hypothesis selection module 9-104.

The event types relationship presentation module 9-228, in various alternative implementations, may include a time/temporal relationship presentation module 9-234 that is configured to present an indication of a time or temporal relationship between the at least first event type and the at least second event type linked together by the at least one hypothesis 9-81*. In some implementations, the event types relationship presentation module 9-228 may be configured to present an indication of a spatial relationship between the at least first event type and the at least second event type linked together by the at least one hypothesis 9-81*.

In some implementations, the presentation module 9-106 may include a prediction presentation module 9-238 that is configured to present (e.g., transmit via a wireless and/or wired network 9-40 or indicate via a user interface 9-122) an advisory relating to a prediction of a future event. Such an advisory may be based on the at least one hypothesis 9-81* selected by the hypothesis selection module 9-104. For example, suppose the at least one hypothesis 9-81* suggests that there is a link between jogging and sore ankles, then upon the events data acquisition module 9-102 acquiring data indicating that a user 9-20* went jogging, then the predication presentation module 9-238 may present an indication that the user 9-20* will subsequently have sore ankles

In the same or different implementations, the presentation module 9-106 may include a recommendation presentation module 9-240 that may be configured to present (e.g., transmit via a wireless and/or wired network 9-40 or indicate via a user interface 9-122) a recommendation for a future course of action. Such a recommendation may be based, at least in part, on the at least one hypothesis 9-81* selected by the hypothesis selection module 9-104. For example, referring back to the above jogging/sore ankle example, the recommendation presentation module 9-240 may recommend that the user 9-20* ingest aspirin.

In some implementations, the recommendation presentation module 9-240 may include a justification presentation module 9-242 that may be configured to present a justification for the recommendation presented by the recommendation presentation module 9-240. For example, in the above jogging/sore ankle example, the justification presentation module 9-242 may present an indication that the user 9-20* should ingest the aspirin because her ankles will be sore as a result of jogging.

In various alternative implementations, the presentation module 9-106 may include a past events presentation module 9-244 that may be configured to present (e.g., transmit via a wireless and/or wired network 9-40 or indicate via a user interface 9-122) an indication of one or more past events. Such a presentation of past events may be based, at least in part, on the at least one hypothesis 9-81* selected by the hypothesis selection module 9-104. For example, in the above jogging/sore ankle example, the past events presentation module 9-244 may be designed to present an indication that the user 9-20* in the past seems to always have sore ankles after going jogging.

In various implementations, the computing device 9-10 may include a hypothesis development module 9-108 that may be configured to develop one or more hypothesis 9-81* (e.g., create new hypotheses or to further refine hypotheses). In various implementations, the development of a hypothesis 9-81* may be based, at least in part, on events data 9-60* that indicate one or more reported events. In some cases, the development of a hypothesis 9-81* may be further based on historical data such as historical medical data, population data, past user data (e.g., past user data indicating past reported events associated with a user 9-20*), and so forth.

In various implementations, the computing device 9-10 of FIG. 9-1b may include one or more applications 9-126. The one or more applications 9-126 may include, for example, one or more communication applications 9-267 (e.g., text messaging application, instant messaging application, email application, voice recognition system, and so forth) and/or Web 2.0 application 9-268 to facilitate in communicating via, for example, the World Wide Web. In some implementations, copies of the one or more applications 9-126 may be stored in memory 9-140.

In various implementations, the computing device 9-10 may include a network interface 9-120, which may be a device designed to interface with a wireless and/or wired network 9-40. Examples of such devices include, for example, a network interface card (NIC) or other interface devices or systems for communicating through at least one of a wireless network or wired network 9-40. In some implementations, the computing device 9-10 may include a user interface 9-122. The user interface 9-122 may comprise any device that may interface with a user 9-20b. Examples of such devices include, for example, a keyboard, a display monitor, a touchscreen, a microphone, a speaker, an image capturing device such as a digital or video camera, a mouse, and so forth.

The computing device 9-10 may include a memory 9-140. The memory 9-140 may include any type of volatile and/or non-volatile devices used to store data. In various implementations, the memory 9-140 may include, for example, a mass storage device, read only memory (ROM), programmable read only memory (PROM), erasable programmable read-only memory (EPROM), random access memory (RAM), flash memory, synchronous random access memory (SRAM), dynamic random access memory (DRAM), and/or other memory devices. In various implementations, the memory 9-140 may store a plurality of hypotheses 9-80.

The various features and characteristics of the components, modules, and sub-modules of the computing device 9-10 presented thus far will be described in greater detail with respect to the processes and operations to be described herein.

FIG. 9-3 illustrates an operational flow 9-300 representing example operations related to, among other things, hypothesis selection from a plurality of hypotheses and presentation of one or more advisories in response to the selection. In some embodiments, the operational flow 9-300 may be executed by, for example, the computing device 9-10 of FIG. 9-1b, which may be a server or a standalone device.

In FIG. 9-3 and in the following figures that include various examples of operational flows, discussions and explanations may be provided with respect to the above-described exemplary environment of FIGS. 9-1a and 9-1b, and/or with respect to other examples (e.g., as provided in FIGS. 9-2a to 9-2c) and contexts. However, it should be understood that the operational flows may be executed in a number of other environments and contexts, and/or in modified versions of FIGS. 9-1a, 9-1b, and 9-2a to 9-2c. Also, although the various operational flows are presented in the sequence(s) illustrated, it should be understood that the various operations may be performed in different sequential orders other than those which are illustrated, or may be performed concurrently.

Further, in the following figures that depict various flow processes, various operations may be depicted in a box-within-a-box manner. Such depictions may indicate that an operation in an internal box may comprise an optional example embodiment of the operational step illustrated in one or more external boxes. However, it should be understood that internal box operations may be viewed as independent operations separate from any associated external boxes and may be performed in any sequence with respect to all other illustrated operations, or may be performed concurrently.

In any event, after a start operation, the operational flow 9-300 may move to a hypothesis selection operation 9-302 for selecting at least one hypothesis from a plurality of hypotheses relevant to a user, the selection of the at least one hypothesis being based, at least in part, on at least one reported event associated with the user. For instance, the hypothesis selection module 9-104 of the computing device 9-10 selecting at least one hypothesis 9-81* (e.g., a hypothesis that correlates or links a first event type with a second event type) from a plurality of hypotheses 9-80 relevant to a user 9-20* (e.g., hypotheses 9-80 that may be specifically relevant to the user 9-20* or at least to a sub-group of the population that the user 9-20* belongs to), the selection of the at least one hypothesis 9-81* being based, at least in part, on at least one reported event associated with the user 9-20*. Note that in the following description and for ease of illustration and understanding the hypothesis 9-81* to be selected through the hypothesis selection operation 9-302 may be described as a hypothesis that links together or associates two types of events (i.e., event types). However, those skilled in the art will recognize that such a hypothesis 9-81* may actually relate to the linking together of three or more types of events in various alternative implementations.

Next, operational flow 9-300 may include an advisory presentation operation 9-304 for presenting one or more advisories related to the hypothesis. For instance, the presentation module 9-106 of the computing device 9-10 presenting (e.g., transmitting through a wireless and/or wired network 9-40, or indicating via a user interface 9-122) one or more advisories 9-90 (e.g., an advisory relating to one or more past events, a recommendation for a future action, and so forth) related to the hypothesis 9-81*.

The at least one hypothesis 9-81* to be selected during the hypothesis selection operation 9-302 of FIG. 9-3 may be related to one or more types of events (i.e., event types) in various alternative implementations. For example, in some implementations, the hypothesis selection operation 9-302 may include an operation 9-402 for selecting at least one hypothesis that relates to at least one subjective user state type as depicted in FIG. 9-4a. For instance, the hypothesis selection module 9-104 of the computing device 9-10 selecting at least one hypothesis 9-81* that relates to at least one subjective user state type (e.g., a subjective mental state such as anger, a subjective user state such as upset stomach, or a subjective overall state such as “good”).

In various implementations, the at least one hypothesis 9-81* to be selected through operation 9-402 may be directed to any one or more of a number of different types of subjective user states. For example, in some implementations, operation 9-402 may include an operation 9-403 for selecting at least one hypothesis that relates to at least one subjective mental state type as depicted in FIG. 9-4a. For instance, the hypothesis selection module 9-104 of the computing device 9-10 selecting at least one hypothesis 9-81* that relates to at least one subjective mental state type (e.g., anger, happiness, depression, alertness, nausea, jealousy, mental fatigue, and so forth).

In the same or different implementations, operation 9-402 may include an operation 9-404 for selecting at least one hypothesis that relates to at least one subjective physical state type as depicted in FIG. 9-4a. For instance, the hypothesis selection module 9-104 of the computing device 9-10 selecting at least one hypothesis 9-81* that relates to at least one subjective physical state type (e.g., upset stomach, pain, blurry vision, cramps, and so forth).

In the same or different implementations, operation 9-402 may include an operation 9-405 for selecting at least one hypothesis that relates to at least one subjective overall state type as depicted in FIG. 9-4a. For instance, the hypothesis selection module 9-104 of the computing device 9-10 selecting at least one hypothesis 9-81* that relates to at least one subjective overall state type (e.g., overall wellness, availability, unavailability or occupied, overall fatigue, and so forth).

In various implementations, the at least one hypothesis 9-81* to be selected through the hypothesis selection operation 9-302 may be related to at least one type of objective occurrence (i.e., objective occurrence type). For example, in some implementations, the hypothesis selection operation 9-302 may include an operation 9-406 for selecting at least one hypothesis that relates to at least one objective occurrence type as depicted in FIG. 9-4a. For instance, the hypothesis selection module 9-104 of the computing device 9-10 selecting at least one hypothesis 9-81* that relates to at least one objective occurrence type (e.g., user activity, external event, user geographical location, and so forth).

In various implementations, operation 9-406 may include one or more additional operations. For example, in some implementations, operation 9-406 may include an operation 9-407 for selecting at least one hypothesis that relates to at least a type of user activity as depicted in FIG. 9-4a. For instance, the hypothesis selection module 9-104 of the computing device 9-10 selecting at least one hypothesis 9-81* that relates to at least a type of user activity (e.g., consumption of an edible item, a type of social activity, a type of exercise activity, and so forth).

In some implementations, operation 9-407 may include an operation 9-408 for selecting at least one hypothesis that relates to at least a consumption of an item as depicted in FIG. 9-4a. For instance, the hypothesis selection module 9-104 of the computing device 9-10 selecting at least one hypothesis 9-81* that relates to at least a consumption of an item (e.g., an edible item such as food, herbs, beverages, medicine, nutraceuticals, and so forth).

Operation 9-408, in turn, may further include one or more operations in various alternative implementations. For example, in some implementations, operation 9-408 may include an operation 9-409 for selecting at least one hypothesis that relates to at least a consumption of a type of food item as depicted in FIG. 9-4a. For instance, the hypothesis selection module 9-104 of the computing device 9-10 selecting at least one hypothesis 9-81* that relates to at least a consumption of a type of food item (e.g., fruits, vegetables, meats, particular dishes, ethnic foods, alcoholic beverages, coffee, and so forth).

In the same or different implementations, operation 9-408 may include an operation 9-410 for selecting at least one hypothesis that relates to at least a consumption of a type of medicine as depicted in FIG. 9-4a. For instance, the hypothesis selection module 9-104 of the computing device 9-10 selecting at least one hypothesis 9-81* that relates to at least a consumption of a type of medicine (e.g., pain killers such as aspirin or ibuprofen, cold medication, alpha blockers, insulin, and so forth).

In the same or different implementations, operation 9-408 may include an operation 9-411 for selecting at least one hypothesis that relates to at least a consumption of a type of nutraceutical as depicted in FIG. 9-4a. For instance, the hypothesis selection module 9-104 of the computing device 9-10 selecting at least one hypothesis 9-81* that relates to at least a consumption of a type of nutraceutical (e.g., carrots, broccoli, red wine, green tea, and so forth).

In some implementations, operation 9-407 may include an operation 9-412 for selecting at least one hypothesis that relates to a type of exercise activity as depicted in FIG. 9-4b. For instance, the hypothesis selection module 9-104 of the computing device 9-10 selecting at least one hypothesis 9-81* that relates to a type of exercise activity (e.g., working out on an exercise machine such as a treadmill or elliptical machine, jogging, lifting weights, aerobics, swimming, and so forth).

In some implementations, operation 9-407 may include an operation 9-413 for selecting at least one hypothesis that relates to a type of social activity as depicted in FIG. 9-4b. For instance, the hypothesis selection module 9-104 of the computing device 9-10 selecting at least one hypothesis 9-81* that relates to a type of social activity (e.g., attending a party, dinner engagement with family and/or friends, playing with children, attending a play or movie with friends or family, playing golf with friends, and so forth).

In some implementations, operation 9-407 may include an operation 9-414 for selecting at least one hypothesis that relates to a type of recreational activity as depicted in FIG. 9-4b For instance, the hypothesis selection module 9-104 of the computing device 9-10 selecting at least one hypothesis 9-81* that relates to a type of recreational activity (e.g., playing golf or bowling, fishing, reading, watching television or movie, and so forth). Note that certain activities may belong to more than one objective occurrence type. For example, in the above, playing golf could be either a recreational activity or a social activity.

In some implementations, operation 9-407 may include an operation 9-415 for selecting at least one hypothesis that relates to a type of learning or type of educational activity as depicted in FIG. 9-4b. For instance, the hypothesis selection module 9-104 of the computing device 9-10 selecting at least one hypothesis 9-81* that relates to a type of learning or type of educational activity (e.g., reading a book, attending a class or lecture, and so forth).

In various implementations, operation 9-406 of FIG. 9-4a may include an operation 9-416 for selecting at least one hypothesis that relates to one or more types of activities performed by one or more third parties as depicted in FIG. 9-4b. For instance, the hypothesis selection module 9-104 of the computing device 9-10 selecting at least one hypothesis 9-81* that relates to one or more types of activities performed by one or more third parties 9-50 (e.g., a spouse or a boss going on a trip, children returning home from college, in-laws visiting, and so forth).

In the same or different implementations, operation 9-406 may include an operation 9-417 for selecting at least one hypothesis that relates to one or more types of user physical characteristics as depicted in FIG. 9-4b. For instance, the hypothesis selection module 9-104 of the computing device 9-10 selecting at least one hypothesis 9-81* that relates to one or more types of user physical characteristics (e.g., blood pressure, blood sugar level, heart rate, bacterial or viral infections, physical injuries, and so forth).

In the same or different implementations, operation 9-406 may include an operation 9-418 for selecting at least one hypothesis that relates to one or more types of external activities as depicted in FIG. 9-4b. For instance, the hypothesis selection module 9-104 of the computing device 9-10 selecting at least one hypothesis 9-81* that relates to one or more types of external activities (e.g., weather, performance of sports team, stock market performance, and so forth).

In the same or different implementations, operation 9-406 may include an operation 9-419 for selecting at least one hypothesis that relates to one or more locations as depicted in FIG. 9-4b. For instance, the hypothesis selection module 9-104 of the computing device 9-10 selecting at least one hypothesis 9-81* that relates to one or more locations (e.g., geographical locations such as Hawaii or place of employment).

In various implementations, the hypothesis selection operation 9-302 may include an operation 9-420 for selecting at least one hypothesis that relates to at least one subjective observation type as depicted in FIG. 9-4c. For instance, the hypothesis selection module 9-104 of the computing device 9-10 selecting at least one hypothesis 9-81* that relates to at least a subjective observation type (e.g., subjective interpretation of another person's activities or of external events).

Operation 9-420, in turn, may further include one or more additional operations in various alternative implementations. For example, in some implementations, operation 9-420 may include an operation 9-421 for selecting at least one hypothesis that relates to at least one type of subjective observation relating to a person as depicted in FIG. 9-4c. For instance, the hypothesis selection module 9-104 of the computing device 9-10 selecting at least one hypothesis 9-81* that relates to at least one type of subjective observation relating to a person (e.g., a subjective interpretation of another person's behavior or actions).

In some implementations, operation 9-421 may further include an operation 9-422 for selecting at least one hypothesis that relates to at least one type of subjective observation relating to a subjective user state of the person as depicted in FIG. 9-4c. For instance, the hypothesis selection module 9-104 of the computing device 9-10 selecting at least one hypothesis 9-81* that relates to at least one type of subjective observation relating to a subjective user state of the person (e.g., subjective mental state such as anger). For example, one person observing that a second person having a scowling expression and concluding or observing that the second person is angry.

Operation 9-422, in turn, may include one or more additional operations. For example, in some implementations, operation 9-422 may include an operation 9-423 for selecting at least one hypothesis that relates to at least one type of subjective observation relating to a subjective mental state of the person as depicted in FIG. 9-4c. For instance, the hypothesis selection module 9-104 of the computing device 9-10 selecting at least one hypothesis 9-81* that relates to at least one type of subjective observation relating to a subjective mental state of the person (e.g., a subjective observation made by a person about the alertness or inattentiveness of another person).

In the same or different implementations, operation 9-422 may include an operation 9-424 for selecting at least one hypothesis that relates to at least one type of subjective observation relating to a subjective physical state of the person as depicted in FIG. 9-4c. For instance, the hypothesis selection module 9-104 of the computing device 9-10 selecting at least one hypothesis 9-81* that relates to at least one type of subjective observation relating to a subjective physical state of the person (e.g., a subjective observation made by a person that another person is in pain).

In the same or different implementations, operation 9-422 may include an operation 9-425 for selecting at least one hypothesis that relates to at least one type of subjective observation relating to a subjective overall state of the person as depicted in FIG. 9-4c. For instance, the hypothesis selection module 9-104 of the computing device 9-10 selecting at least one hypothesis 9-81* that relates to at least one type of subjective observation relating to a subjective overall state of the person (e.g., a subjective observation made by a person that another person appears to be well).

In some implementations, operation 9-420 may include an operation 9-426 for selecting at least one hypothesis that relates to at least one type of subjective observation relating to a type of activity performed by a person as depicted in FIG. 9-4c. For instance, the hypothesis selection module 9-104 of the computing device 9-10 selecting at least one hypothesis 9-81* that relates to at least one type of subjective observation relating to a type of activity performed by a person (e.g., subjective observation made by a person of another person's work performance).

In some implementations, operation 9-420 may include an operation 9-427 for selecting at least one hypothesis that relates to at least one type of subjective observation relating to an occurrence of an external event as depicted in FIG. 9-4c. For instance, the hypothesis selection module 9-104 of the computing device 9-10 selecting at least one hypothesis 9-81* that relates to at least one type of subjective observation relating to an occurrence of an external event (e.g., a subjective observation of the performance of the stock market).

Referring back to the hypothesis selection operation 9-302 of FIG. 9-3, in various implementations the hypothesis selection operation 9-302 may include an operation 9-428 for selecting from the plurality of hypotheses at least one hypothesis that links at least a first event type with at least a second event type as depicted in FIG. 9-4d. For instance, the hypothesis selection module 9-104 of the computing device 9-10 selecting from the plurality of hypotheses 9-80 at least one hypothesis 9-81* that links at least a first event type (e.g., a subjective user state type, an objective occurrence type, or a subjective observation type) with at least a second event type (e.g., a subjective user state type, an objective occurrence type, or a subjective observation type). Note that in various alternative implementations a hypothesis 9-81* may link two similar types of events such as two objective occurrences or two subjective user states. For example, a hypothesis 9-81* that links the consumption of rice with high blood sugar level, both of which are objective occurrences. In another example, linking together the feeling of depression that occurs prior to feeling elation, both of which are subjective user states.

Thus, in various implementations, operation 9-428 may involve selecting a hypothesis 9-81* that links similar or different types of events. For example, in some implementations, operation 9-428 may include an operation 9-429 for selecting at least one hypothesis that links at least a first subjective user state type with at least a second subjective user state type as depicted in FIG. 9-4d. For instance, the hypothesis selection module 9-104 of the computing device 9-10 selecting at least one hypothesis 9-81* that links at least a first subjective user state type (e.g., inattention or distracted) with at least a second subjective user state type (e.g., anger). For example, such a hypothesis 9-81* may suggest that a person may be inattentive whenever the person is angry.

In some implementations, operation 9-428 may include an operation 9-430 for selecting at least one hypothesis that links at least one subjective user state type with at least one objective occurrence type as depicted in FIG. 9-4d. For instance, the hypothesis selection module 9-104 of the computing device 9-10 selecting at least one hypothesis 9-81* that links at least one subjective user state type (e.g., subjective overall state such as “good”) with at least one objective occurrence type (e.g., occurrence of an external event such as favorite sports team winning) For example, such a hypothesis 9-81* may suggest that a person may feel good when his/her favorite sports team wins.

In some implementations, operation 9-428 may include an operation 9-431 for selecting at least one hypothesis that links at least one subjective user state type with at least one subjective observation type as depicted in FIG. 9-4d. For instance, the hypothesis selection module 9-104 of the computing device 9-10 selecting at least one hypothesis 9-81* that links at least one subjective user state type (e.g., fatigued) with at least one subjective observation type (e.g., subjective observation of anger). For example, such a hypothesis 9-81* may suggest that a person when fatigued may appear to be angry by others.

In some implementations, operation 9-428 may include an operation 9-432 for selecting at least one hypothesis that links at least a first objective occurrence type with at least a second objective occurrence type as depicted in FIG. 9-4d. For instance, the hypothesis selection module 9-104 of the computing device 9-10 selecting at least one hypothesis 9-81* that links at least a first objective occurrence type (e.g., stock market crash) with at least a second objective occurrence type (e.g., high blood pressure). For example, such a hypothesis 9-81* may suggest that a person's blood pressure may elevate whenever the stock market crashes.

In some implementations, operation 9-428 may include an operation 9-433 for selecting at least one hypothesis that links at least one objective occurrence type with at least one subjective observation type as depicted in FIG. 9-4d. For instance, the hypothesis selection module 9-104 of the computing device 9-10 selecting at least one hypothesis 9-81* that links at least one objective occurrence type (e.g., reduced blood pressure) with at least one subjective observation type (e.g., happy boss). For example, such a hypothesis 9-81* may suggest that a person's blood pressure may be reduced when the person observes that the person's boss appears to be happy.

In some implementations, operation 9-428 may include an operation 9-434 for selecting at least one hypothesis that links at least a first subjective observation type with at least a second subjective observation type as depicted in FIG. 9-4d. For instance, the hypothesis selection module 9-104 of the computing device 9-10 selecting at least one hypothesis 9-81* that links at least a first subjective observation type (e.g., happy spouse) with at least a second subjective observation type (e.g., nice weather). For example, such a hypothesis 9-81* may suggest that when a spouse reports that the weather appears to be nice, the spouse may also appear to be happy as observed by the spouse's partner.

In some implementations, operation 9-428 may include an operation 9-435 for selecting at least one hypothesis that at least sequentially links at least a first event type with at least a second event type as depicted in FIG. 9-4d. For instance, the hypothesis selection module 9-104 of the computing device 9-10 selecting at least one hypothesis 9-81* that at least sequentially links at least a first event type (e.g., eating spicy foods) with at least a second event type (e.g., upset stomach). For example, such a hypothesis 9-81* may suggest that after eating spicy foods, a person may develop a stomach ache.

In some implementations, operation 9-428 may include an operation 9-436 for selecting at least one hypothesis that at least spatially links at least a first event type with at least a second event type as depicted in FIG. 9-4d. For instance, the hypothesis selection module 9-104 of the computing device 9-10 selecting at least one hypothesis 9-81* that at least spatially links at least a first event type (e.g., depression) with at least a second event type (happiness). For example, such a hypothesis 9-81* may suggest that a person is happier in Hawaii than being in Los Angeles.

In various implementations, the at least one hypothesis 9-81* (as well as, in some cases, the plurality of hypotheses 9-80), may have been originally developed based on historical data specifically associated with the user 9-20* or on historical data specifically associated with at least a sub-group of the general population that the user 9-20* belongs to. For example, in some implementations, the hypothesis selection operation 9-302 of FIG. 9-3 may include an operation 9-437 for selecting at least one hypothesis that was developed based, at least in part, on historical data associated with the user as depicted in FIG. 9-4e. For instance, the hypothesis selection module 9-104 of the computing device 9-10 selecting at least one hypothesis 9-81* that was developed based, at least in part, on historical data (e.g., historical medical data associated with the user 9-20*, previously reported events data including data indicating patterns of past reported events associated with the user 9-20*, and so forth) associated with the user 9-20*.

In some implementations, operation 9-437 may further include an operation 9-438 for selecting at least one hypothesis that was developed based, at least in part, on a historical events pattern specifically associated with the user as depicted in FIG. 9-4e. For instance, the hypothesis selection module 9-104 of the computing device 9-10 selecting at least one hypothesis 9-81* that was developed based, at least in part, on a historical events pattern (e.g., an events pattern that indicates increased relaxation following 30 minutes of exercise) specifically associated with the user 9-20*.

In various implementations, the hypothesis selection operation 9-302 of FIG. 9-3 may include an operation 9-439 for selecting at least one hypothesis that was developed based, at least in part, on historical data associated with at least a sub-group of a population, the user being included in the sub-group as depicted in FIG. 9-4e. For instance, the hypothesis selection module 9-104 of the computing device 9-10 selecting at least one hypothesis 9-81* that was developed based, at least in part, on historical data (e.g., medical data) associated with at least a sub-group (e.g., a particular ethnic group) of a population, the user 9-20* being included in the sub-group.

In some implementations, operation 9-439 may include an operation 9-440 for selecting at least one hypothesis that was developed based, at least in part, on a historical events pattern associated with at least the sub-group of the population as depicted in FIG. 9-4e. For instance, the hypothesis selection module 9-104 of the computing device 9-10 selecting at least one hypothesis 9-81* that was developed based, at least in part, on a historical events pattern (e.g., an events pattern that indicates a relationship between diarrhea and consumption of dairy products) associated with at least the sub-group of the population.

In some implementations, the hypothesis selection operation 9-302 may include an operation 9-441 for selecting at least one hypothesis from a plurality of hypotheses, the plurality of hypotheses being specifically associated with the user as depicted in FIG. 9-4e. For instance, the hypothesis selection module 9-104 of the computing device 9-10 selecting at least one hypothesis 9-81* from a plurality of hypotheses 9-80, the plurality of hypotheses 9-80 being specifically associated with the user 9-20*. For example, each of the plurality of hypothesis 9-80 may have been developed based on patterns of reported events associated with the user 9-20*.

In various implementations, the hypothesis selection operation 9-302 may include an operation 9-442 for selecting at least one hypothesis from a plurality of hypotheses, the plurality of hypotheses being specifically associated with at least a sub-group of a population, the user being a member of the sub-group as depicted in FIG. 9-4e. For instance, the hypothesis selection module 9-104 of the computing device 9-10 selecting at least one hypothesis 9-81* from a plurality of hypotheses 9-80, the plurality of hypotheses 9-80 being specifically associated with at least a sub-group of a population, the user 9-20* being a member of the sub-group. For example, each of the plurality of hypotheses 9-80 may have been developed based on patterns of reported events associated with at least a sub-group (e.g., gender or age group) of the general population.

The selection of the at least one hypothesis 9-81* in the hypothesis selection operation 9-302 of FIG. 9-3 may be based on a reported event that may have been reported through a variety of reporting methods. For example, in various implementations, the hypothesis selection operation 9-302 may include an operation 9-443 for selecting at least one hypothesis from the plurality of hypotheses based, at least in part, on at least one reported event reported via one or more electronic entries as depicted in FIG. 9-4f. For instance, the hypothesis selection module 9-104 of the computing device 9-10 selecting at least one hypothesis 9-81* from the plurality of hypotheses 9-80 based, at least in part, on at least one reported event (e.g., as referenced by the reported event referencing module 9-208 of the computing device 9-10) reported via one or more electronic entries (e.g., blog or microblog entries, status report entries, diary entries, instant message entries, text messaging entries, and so forth)) as received by, for example, reception module 9-202.

In particular, operation 9-443 may include an operation 9-444 for selecting at least one hypothesis from the plurality of hypotheses based, at least in part, on at least one reported event reported via one or more blog entries in various implementations and as depicted in FIG. 9-4f. For instance, the hypothesis selection module 9-104 of the computing device 9-10 selecting at least one hypothesis 9-81* from the plurality of hypotheses 9-80 based, at least in part, on at least one reported event reported via one or more blog entries (e.g., microblog entries as provided by the user 9-20* or by one or more third parties 9-50 such as other users) as received by, for example, reception module 9-202.

In some implementations, operation 9-443 may include an operation 9-445 for selecting at least one hypothesis from the plurality of hypotheses based, at least in part, on at least one reported event reported via one or more status reports as depicted in FIG. 9-4f. For instance, the hypothesis selection module 9-104 of the computing device 9-10 selecting at least one hypothesis 9-81* from the plurality of hypotheses 9-80 based, at least in part, on at least one reported event reported via one or more status reports (e.g., as provided by the user 9-20* or by one or more third parties 9-50 such as other users) as received by, for example, reception module 9-202.

In some implementations, operation 9-443 may include an operation 9-446 for selecting at least one hypothesis from the plurality of hypotheses based, at least in part, on at least one reported event reported via one or more electronic messages as depicted in FIG. 9-4f. For instance, the hypothesis selection module 9-104 of the computing device 9-10 selecting at least one hypothesis 9-81* from the plurality of hypotheses 9-80 based, at least in part, on at least one reported event reported via one or more electronic messages such as email messages, text messages, IM messages, and so forth (e.g., as provided by the user 9-20* or by one or more third parties 9-50 such as other users) and as received by, for example, reception module 9-202.

In some implementations, operation 9-443 may include an operation 9-447 for selecting at least one hypothesis from the plurality of hypotheses based, at least in part, on at least one reported event reported through one or more electronic entries composed by the user as depicted in FIG. 9-4f. For instance, the hypothesis selection module 9-104 of the computing device 9-10 selecting at least one hypothesis 9-81* from the plurality of hypotheses 9-80 based, at least in part, on at least one reported event reported through one or more electronic entries (e.g., blog or microblog entries, status report entries, diary entries, instant message entries, text messaging entries, and so forth) composed by the user 9-20* and as received by, for example, reception module 9-202.

In some implementations, operation 9-443 may include an operation 9-448 for selecting at least one hypothesis from the plurality of hypotheses based, at least in part, on at least one reported event reported through one or more electronic entries composed by one or more third parties as depicted in FIG. 9-4f. For instance, the hypothesis selection module 9-104 of the computing device 9-10 selecting at least one hypothesis 9-81* from the plurality of hypotheses 9-80 based, at least in part, on at least one reported event reported through one or more electronic entries (e.g., blog or microblog entries, status report entries, diary entries, instant message entries, text messaging entries, and so forth) composed by one or more third parties 9-50 and as received by, for example, reception module 9-202.

In some implementations, operation 9-443 may include an operation 9-449 for selecting at least one hypothesis from the plurality of hypotheses based, at least in part, on at least one reported event reported through one or more electronic entries generated by one or more remote network devices as depicted in FIG. 9-4f. For instance, the hypothesis selection module 9-104 of the computing device 9-10 selecting at least one hypothesis 9-81* from the plurality of hypotheses 9-80 based, at least in part, on at least one reported event reported through one or more electronic entries generated by one or more remote network devices (e.g., network servers, work stations, blood pressure monitors, glucometers, heart rate monitors, GPS, exercise machine sensors, pedometer, accelerometer to measure user movements, toilet monitors to monitor toilet use, and so forth) and as received by, for example, reception module 9-202.

In some implementations, operation 9-449 may further include an operation 9-450 for selecting at least one hypothesis from the plurality of hypotheses based, at least in part, on at least one reported event reported through one or more electronic entries generated by one or more sensors as depicted in FIG. 9-4f. For instance, the hypothesis selection module 9-104 of the computing device 9-10 selecting at least one hypothesis 9-81* from the plurality of hypotheses 9-80 based, at least in part, on at least one reported event reported through one or more electronic entries generated by one or more sensors 9-35 (e.g., blood pressure monitors, glucometers, heart rate monitors, GPS, exercise machine sensors, pedometer, accelerometer to measure user movements, toilet monitors to monitor toilet use, and so forth) and as received by, for example, reception module 9-202.

In various implementations, the hypothesis selection operation 9-302 of FIG. 9-3 may make the selection of the at least one hypothesis 9-81* based on a plurality of reported events. For example, in some implementations, the hypothesis selection operation 9-302 may include an operation 9-451 for selecting the at least one hypothesis from the plurality of hypotheses based, at least in part, on at least the one reported event and a second reported event as depicted in FIG. 9-4g. For instance, the hypothesis selection module 9-104 of the computing device 9-10 selecting at least one hypothesis 9-81* from the plurality of hypotheses 9-80 based, at least in part, on at least the one reported event (e.g., a subjective user state, an objective occurrence, or a subjective occurrence) and a second reported event (e.g., a subjective user state, an objective occurrence, or a subjective occurrence).

In some implementations, operation 9-451 may include an operation 9-452 for selecting the at least one hypothesis from the plurality of hypotheses based, at least in part, on at least one reported event of a first event type and a second reported event of a second event type as depicted in FIG. 9-4g. For instance, the hypothesis selection module 9-104 of the computing device 9-10 selecting at least one hypothesis 9-81* from the plurality of hypotheses 9-80 based, at least in part, on at least one reported event of a first event type (e.g., subjective user state) and a second reported event of a second event type (e.g., objective occurrence).

In some implementations, operation 9-451 may include an operation 9-453 for selecting the at least one hypothesis from the plurality of hypotheses based, at least in part, on at least one reported event that originates from a first source and a second reported event that originates from a second source as depicted in FIG. 9-4g. For instance, the hypothesis selection module 9-104 of the computing device 9-10 selecting at least one hypothesis 9-81* from the plurality of hypotheses 9-80 based, at least in part, on at least one reported event that originates from a first source (e.g., user 9-20*) and a second reported event that originates from a second source (e.g., one or more sensors 9-35 or one or more third parties 9-50).

Various approaches may be employed in the hypothesis selection operation 9-302 of FIG. 9-3 in order to select the at least one hypothesis 9-81* from the plurality of hypotheses 9-80 based on the at least one reported event. For example, in some implementations, the hypothesis selection operation 9-302 may include an operation 9-454 for selecting at least one hypothesis from a plurality of hypotheses based, at least in part, on a comparison of the at least one reported event to one, or both, of a first event type and a second event type linked together by the at least one hypothesis as depicted in FIG. 9-4g. For instance, the hypothesis selection module 9-104 of the computing device 9-10 selecting at least one hypothesis 9-81* from a plurality of hypotheses 9-80 based, at least in part, on a comparison (e.g., as made by the comparison module 9-210) of the at least one reported event (e.g., reporting consumption of alcoholic beverage) to one, or both, of a first event type (e.g., feeling a hangover) and a second event type (e.g., consuming alcoholic beverage) linked together by the at least one hypothesis 9-81*.

In some implementations, operation 9-454 may further include an operation 9-455 for selecting the at least one hypothesis based, at least in part, on determining whether the at least one reported event at least substantially matches with the first event type or the second event type as depicted in FIG. 9-4g. For instance, the hypothesis selection module 9-104 of the computing device 9-10 selecting the at least one hypothesis 9-81* based, at least in part, on determining whether the at least one reported event (e.g., reporting a cloudy weather) at least substantially matches (e.g., as substantially matched by the matching module 9-212) with the first event type (e.g., feeling melancholy) or the second event type (e.g., overcast weather).

In some implementations, operation 9-454 may include an operation 9-456 for selecting the at least one hypothesis based, at least in part, on a comparison of a second reported event to one, or both, of the first event type and the second event type as depicted in FIG. 9-4g. For instance, the hypothesis selection module 9-104 of the computing device 9-10 selecting the at least one hypothesis 9-81* based, at least in part, on a comparison (e.g., as compared by the comparison module 9-210) of a second reported event (e.g., reporting a hangover) to one, or both, of the first event type (e.g., consuming alcoholic beverage) and the second event type (e.g., feeling a hangover).

In various implementations, operation 9-456 may further include an operation 9-457 for selecting the at least one hypothesis based, at least in part, on determining whether the second reported event at least substantially matches with the first event type or the second event type as depicted in FIG. 9-4g. For instance, the hypothesis selection module 9-104 of the computing device 9-10 selecting the at least one hypothesis 9-81* based, at least in part, on determining whether the second reported event (e.g., reporting feeling depressed) at least substantially matches (e.g., as substantially matched by the matching module 9-212) with the first event type (e.g., overcast weather) or the second event type (e.g., feeling melancholy).

In some implementations, operation 9-456 may include an operation 9-458 for selecting the at least one hypothesis based, at least in part, on determining whether the second reported event is a contrasting event from the first event type or the second event type as depicted in FIG. 9-4g. For instance, the hypothesis selection module 9-104 of the computing device 9-10 selecting the at least one hypothesis 9-81* based, at least in part, on determining whether the second reported event (e.g., reporting feeling happy) is a contrasting event (e.g., as determined by the contrasting module 9-214) from the first event type (e.g., overcast weather) or the second event type (e.g., feeling melancholy). Note that such an operation may ultimately result in the assessment that the at least one hypothesis 9-81* is not a sound or strong hypothesis particularly as it relates to, for example, the user 9-20*.

In some implementations, operation 9-456 may include an operation 9-459 for selecting the at least one hypothesis based, at least in part, on determining a relationship between the first reported event and the second reported event as depicted in FIG. 9-4h. For instance, the hypothesis selection module 9-104 of the computing device 9-10 selecting the at least one hypothesis 9-81* based, at least in part, on determining a relationship (e.g., the relationship determination module 9-216 determining a sequential or spatial relationship) between the first reported event (e.g., high blood sugar level) and the second reported event (e.g., consuming white rice).

Operation 9-459, in some implementations, may include an operation 9-460 for selecting the at least one hypothesis based, at least in part, on determining a sequential link between the first reported event and the second reported event as depicted in FIG. 9-4h. For instance, the hypothesis selection module 9-104 of the computing device 9-10 selecting the at least one hypothesis 9-81* based, at least in part, on determining a sequential link (e.g., the sequential link determination module 9-218 determining a temporal relationship or a more specific time relationship) between the first reported event and the second reported event.

In some implementations, operation 9-459 may include an operation 9-461 for selecting the at least one hypothesis based, at least in part, on determining a spatial link between the first reported event and the second reported event as depicted in FIG. 9-4h. For instance, the hypothesis selection module 9-104 of the computing device 9-10 selecting the at least one hypothesis 9-81* based, at least in part, on determining a spatial link (e.g., as determined by the spatial link determination module 9-220) between the first reported event and the second reported event.

In some implementations, operation 9-459 may include an operation 9-462 for selecting the at least one hypothesis based, at least in part, on comparing the relationship between the first reported event and the second reported event to a relationship between the first event type and the second event type of the at least one hypothesis as depicted in FIG. 9-4h. For instance, the hypothesis selection module 9-104 of the computing device 9-10 selecting the at least one hypothesis 9-81* based, at least in part, on comparing (e.g., as compared by the comparison module 9-210) the relationship between the first reported event and the second reported event to a relationship between the first event type and the second event type of the at least one hypothesis 9-81*.

The hypothesis selection operation 9-302 of FIG. 9-3 may be executed in various types of devices in various environments. For example, in some implementations, the hypothesis selection operation 9-302 may include an operation 9-463 for selecting the at least one hypothesis at a server as depicted in FIG. 9-4i. For instance, the hypothesis selection module 9-104 of the computing device 9-10 selecting the at least one hypothesis 9-81* when the computing device 9-10 is a network server.

In other alternative implementations, the hypothesis selection operation 9-302 may include an operation 9-464 for selecting the at least one hypothesis at a standalone device as depicted in FIG. 9-4i. For instance, the hypothesis selection module 9-104 of the computing device 9-10 selecting the at least one hypothesis 9-81* when the computing device 9-10 is a standalone device (e.g., a desktop computer, a laptop computer, a workstation, or a handheld device such as a cellular telephone, a smartphone, a PDA, an MID, an UMPC, and so forth).

In some implementations, operation 9-464 may further include an operation 9-465 for selecting the at least one hypothesis at a handheld device as depicted in FIG. 9-4i. For instance, the hypothesis selection module 9-104 of the computing device 9-10 selecting the at least one hypothesis 9-81* when the computing device 9-10 is a handheld device (e.g., cellular telephone, a smartphone, a PDA, an MID, an UMPC, and so forth).

In some implementations, the hypothesis selection operation 9-302 may include an operation 9-466 for selecting the at least one hypothesis at a peer-to-peer network component device as depicted in FIG. 9-4i. For instance, the hypothesis selection module 9-104 of the computing device 9-10 selecting the at least one hypothesis 9-81* when the computing device 9-10 is a peer-to-peer network component device.

In some implementations, the hypothesis selection operation 9-302 may include an operation 9-467 for selecting the at least one hypothesis via a Web 2.0 construct as depicted in FIG. 9-4i. For instance, the hypothesis selection module 9-104 of the computing device 9-10 selecting the at least one hypothesis 9-81* via a Web 2.0 construct (e.g., Web 2.0 application 9-268).

Referring back to the operational flow 9-300 of FIG. 9-3, the advisory presentation operation 9-304 of operational flow 9-300 may be executed in a number different ways in various alternative implementations. For example, in some implementations, the advisory presentation operation 9-304 may include an indication operation 9-502 for indicating the one or more advisories related to the hypothesis via a user interface as depicted in FIG. 9-5a. For instance, the indication module 9-222 (see FIG. 9-2c) of the computing device 9-10 indicating the one or more advisories related to the hypothesis 9-81* via a user interface 9-122 (e.g., a display monitor such as a liquid crystal display, a touch screen, an audio system including one or more speakers, and/or other interface devices).

In various implementations, the advisory presentation operation 9-304 may include a transmission operation 9-504 for transmitting the one or more advisories related to the hypothesis via at least one of a wireless network or a wired network as depicted in FIG. 9-5a. For instance, the transmission module 9-224 (see FIG. 9-2c) of the computing device 9-10 transmitting the one or more advisories 9-90 (e.g., a recommendation for a future action based on the hypothesis 9-81* or an alert regarding the hypothesis 9-81*) related to the hypothesis 9-81* via at least one of a wireless network or a wired network 9-40. In some cases, the computing device 9-10 may employ a network interface 9-120 in order to transmit the one or more advisories 9-90.

In some implementations, the transmission operation 9-504 may include an operation 9-506 for transmitting the one or more advisories related to the hypothesis to the user as depicted in FIG. 9-5a. For instance, the transmission module 9-224 of the computing device 9-10 transmitting the one or more advisories 9-90 related to the hypothesis 9-81* to the user 9-20a. For example, transmitting to the user 9-20a an advisory relating to the soundness of the hypothesis 9-81* in the form of a text or audio message such as “you seem to always have a stomach ache after you eat spicy foods” or “there may be a strong link between your melancholy feelings and cloudy weather.”

In some implementations, the transmission operation 9-504 may include an operation 9-508 for transmitting the one or more advisories related to the hypothesis to one or more third parties as depicted in FIG. 9-5a. For instance, the transmission module 9-224 of the computing device 9-10 transmitting the one or more advisories 9-90 related to the hypothesis 9-81* to one or more third parties 9-50 (e.g., other users, network service providers, content providers, advertisers, and so forth).

In some implementations, the advisory presentation operation 9-304 may include a hypothesis presentation operation 9-510 for presenting at least one form of the hypothesis as depicted in FIG. 9-5a. For instance, the hypothesis presentation module 9-226 of the computing device 9-10 presenting (e.g., either transmitting via a network interface 9-120 or indicating via a user interface 9-122) at least one form of the hypothesis 9-81* (e.g., in a graphical or iconic form, in audio form, and/or in a textual form).

In various implementations, the hypothesis presentation operation 9-510 may include an operation 9-512 for presenting an indication of a relationship between at least a first event type and at least a second event type as referenced by the hypothesis as depicted in FIG. 9-5a. For instance, the event types relationship presentation module 9-228 of the computing device 9-10 presenting an indication of a relationship (e.g., sequential or spatial relationship) between at least a first event type (e.g., a subjective user state) and at least a second event type (e.g., an objective occurrence) as referenced by the hypothesis 9-81*.

In various implementations, operation 9-512 may include an operation 9-514 for presenting an indication of soundness of the hypothesis as depicted in FIG. 9-5a. For instance, the soundness presentation module 9-230 of the computing device 9-10 presenting (e.g., either transmitting via a network interface 9-120 or indicating via a user interface 9-122) an indication of soundness of the hypothesis 9-81*. For example, indicating that the hypothesis 9-81* is a weak or a strong hypothesis.

In some implementations, operation 9-514 may further include an operation 9-516 for presenting an indication of strength or weakness of correlation between the at least first event type and the at least second event type linked together by the hypothesis as depicted in FIG. 9-5a. For instance, the strength/weakness presentation module 9-232 of the computing device 9-10 presenting (e.g., either transmitting via a network interface 9-120 or indicating via a user interface 9-122) an indication of strength or weakness of correlation between the at least first event type (e.g., stomach ache) and the at least second event type (e.g., consuming spicy foods) linked together by the hypothesis 9-81*. For example indicating that there is a strong or weak link between eating spicy foods and stomach ache.

In some implementations, operation 9-512 may include an operation 9-518 for presenting an indication of a time or temporal relationship between the at least first event type and the at least second event type as depicted in FIG. 9-5a. For instance, the time/temporal relationship presentation module 9-234 of the computing device 9-10 presenting (e.g., either transmitting via a network interface 9-120 or indicating via a user interface 9-122) an indication of a time or temporal relationship between the at least first event type (e.g., feeling alert) and the at least second event type (e.g., exercising). For example, indicating that if the user 9-20* exercises, the user 9-20* may feel more alert afterwards.

In some implementations, operation 9-512 may include an operation 9-520 for presenting an indication of a spatial relationship between the at least first event type and the at least second event type as depicted in FIG. 9-5a. For instance, the spatial relationship presentation module 9-236 of the computing device 9-10 presenting (e.g., either transmitting via a network interface 9-120 or indicating via a user interface 9-122) an indication of a spatial relationship between the at least first event type (e.g., feeling relaxed) and the at least second event type (e.g., spouse visiting a business client). For example, indicating that the user 9-20* is more relaxed at home when the user's spouse is away in California on a business trip.

In various implementations, operation 9-512 of FIG. 9-5a may include an operation 9-522 for presenting an indication of a relationship between at least a first subjective user state type and at least a second subjective user state type as indicated by the hypothesis as depicted in FIG. 9-5b. For instance, the event types relationship presentation module 9-228 of the computing device 9-10 presenting (e.g., either transmitting via a network interface 9-120 or indicating via a user interface 9-122) an indication of a relationship (e.g., sequential relationship or spatial relationship) between at least a first subjective user state type (e.g., anger) and at least a second subjective user state type (e.g., mental fatigue) as indicated by the hypothesis 9-81*.

In some implementations, operation 9-512 may include an operation 9-524 for presenting an indication of a relationship between at least a first objective occurrence type and at least a second objective occurrence type as indicated by the hypothesis as depicted in FIG. 9-5b. For instance, the event types relationship presentation module 9-228 of the computing device 9-10 presenting (e.g., either transmitting via a network interface 9-120 or indicating via a user interface 9-122) an indication of a relationship (e.g., sequential relationship or spatial relationship) between at least a first objective occurrence type (e.g., consumption of a particular medication) and at least a second objective occurrence type (e.g., elevated blood pressure) as indicated by the hypothesis 9-81*.

In some implementations, operation 9-512 may include an operation 9-526 for presenting an indication of a relationship between at least a first subjective observation type and at least a second subjective observation type as indicated by the hypothesis as depicted in FIG. 9-5b. For instance, the event types relationship presentation module 9-228 of the computing device 9-10 presenting (e.g., either transmitting via a network interface 9-120 or indicating via a user interface 9-122) an indication of a relationship (e.g., sequential relationship or spatial relationship) between at least a first subjective observation type (e.g., an observation that the workload at a place of employment appears to be heavy) and at least a second subjective observation type (e.g., an observation that a worker appears to be very tense) as indicated by the hypothesis 9-81*.

In some implementations, operation 9-512 may include an operation 9-528 for presenting an indication of a relationship between at least a subjective user state type and at least an objective occurrence type as indicated by the hypothesis as depicted in FIG. 9-5b. For instance, the event types relationship presentation module 9-228 of the computing device 9-10 presenting (e.g., either transmitting via a network interface 9-120 or indicating via a user interface 9-122) an indication of a relationship (e.g., sequential relationship or spatial relationship) between at least a subjective user state type (e.g., anger) and at least an objective occurrence type (e.g., elevated blood pressure) as indicated by the hypothesis 9-81*.

In some implementations, operation 9-512 may include an operation 9-530 for presenting an indication of a relationship between at least a subjective user state type and at least a subjective observation type as indicated by the hypothesis as depicted in FIG. 9-5b. For instance, the event types relationship presentation module 9-228 of the computing device 9-10 presenting (e.g., either transmitting via a network interface 9-120 or indicating via a user interface 9-122) an indication of a relationship (e.g., sequential relationship or spatial relationship) between at least a subjective user state type (e.g., elation) and at least a subjective observation type (e.g., observation that the stock market is performing well) as indicated by the hypothesis 9-81*.

In some implementations, operation 9-512 may include an operation 9-532 for presenting an indication of a relationship between at least an objective occurrence type and at least a subjective observation type as indicated by the hypothesis as depicted in FIG. 9-5b. For instance, the event types relationship presentation module 9-228 of the computing device 9-10 presenting (e.g., either transmitting via a network interface 9-120 or indicating via a user interface 9-122) an indication of a relationship (e.g., sequential relationship or spatial relationship) between at least an objective occurrence type (e.g., low blood pressure) and at least a subjective observation type (e.g., observation that a person appears to be content) as indicated by the hypothesis 9-81*.

In various implementations, the advisory presentation operation 9-304 of FIG. 9-3 may include an operation 9-534 for presenting an advisory relating to a predication of a future event as depicted in FIG. 9-5c. For instance, the prediction presentation module 9-238 of the computing device 9-10 presenting (e.g., either transmitting via a network interface 9-120 or indicating via a user interface 9-122) an advisory relating to a predication of a future event. For example, based at least on the hypothesis 9-81* (e.g., a hangover linked to binge drinking) and the reporting of at least one reported event (e.g., binge drinking), an advisory may be presented that indicates that the user 9-20* will have a hangover the next morning.

In various implementations, the advisory presentation operation 9-304 may include an operation 9-536 for presenting a recommendation for a future course of action as depicted in FIG. 9-5c. For instance, the recommendation presentation module 9-240 of the computing device 9-10 presenting (e.g., either transmitting via a network interface 9-120 or indicating via a user interface 9-122) a recommendation for a future action (e.g., “you should take a couple of aspirins this morning”).

In some implementations, operation 9-536 may include an operation 9-538 for presenting a justification for the recommendation as depicted in FIG. 9-5c. For instance, the justification presentation module 9-242 of the computing device 9-10 presenting a justification for the recommendation (e.g., “because you consumed a lot of alcoholic beverages last night, you should take a couple of aspirins this morning”).

In some implementations, the advisory presentation operation 9-304 may include an operation 9-540 for presenting an indication of one or more past events as depicted in FIG. 9-5c. For instance, the past events presentation module 9-244 of the computing device 9-10 presenting (e.g., either transmitting via a network interface 9-120 or indicating via a user interface 9-122) an indication of one or more past events (e.g., “did you know that each time you have eaten Mexican food in the past, you developed a stomach ache?”).

### XI: Hypothesis Development Based on User and Sensing Device Data

In the following detailed description, reference is made to the accompanying drawings, which form a part hereof. In the drawings, similar symbols typically identify similar components, unless context dictates otherwise. The illustrative embodiments described in the detailed description, drawings, and claims are not meant to be limiting. Other embodiments may be utilized, and other changes may be made, without departing from the spirit or scope of the subject matter presented here.

A recent trend that is becoming increasingly popular in the computing/communication field is to electronically record one's feelings, thoughts, and other aspects of the person's everyday life onto an open diary. One place where such open diaries are maintained are at social networking sites commonly known as “blogs” where users may report or post their latest status, personal activities, and various other aspects of the users' everyday life. The process of reporting or posting blog entries is commonly referred to as blogging. Other social networking sites may allow users to update their personal information via, for example, social networking status reports in which a user may report or post for others to view their current status, activities, and/or other aspects of the user.

A more recent development in social networking is the introduction and explosive growth of microblogs in which individuals or users (referred to as “microbloggers”) maintain open diaries at microblog websites (e.g., otherwise known as “twitters”) by continuously or semi-continuously posting microblog entries. A microblog entry (e.g., “tweet”) is typically a short text message that is usually not more than 140 characters long. The microblog entries posted by a microblogger may report on any aspect of the microblogger's daily life. Typically, such microblog entries will describe the various “events” associated with or are of interest to the microblogger that occurs during a course of a typical day. The microblog entries are often continuously posted during the course of a typical day, and thus, by the end of a normal day, a substantial number of events may have been reported and posted.

Each of the reported events that may be posted through microblog entries may be categorized into one of at least three possible categories. The first category of events that may be reported through microblog entries are “objective occurrences” that may or may not be associated with the microblogger. Objective occurrences that are associated with a microblogger may be any characteristic, incident, happening, or any other event that occurs with respect to the microblogger or are of interest to the microblogger that can be objectively reported by the microblogger, a third party, or by a device. Such events would include, for example, intake of food, medicine, or nutraceutical, certain physical characteristics of the microblogger or by others such as blood sugar level or blood pressure that can be objectively measured, activities of the microblogger objectively observable by the microblogger, by others, or by a device, activities of others that may be objectively observed by the microblogger, by others, or by a device, external events such as performance of the stock market (which the microblogger may have an interest in), performance of a favorite sports team, and so forth.

In some cases, objective occurrences may not be at least directly associated with a microblogger. Examples of such objective occurrences include, for example, external events such as the local weather, activities of others (e.g., spouse or boss), the behavior or activities of a pet or livestock, the characteristics or performances of mechanical or electronic devices such as automobiles, appliances, and computing devices, and other events that may directly or indirectly affect the microblogger.

A second category of events that may be reported or posted through microblog entries include “subjective user states” of the microblogger. Subjective user states of a microblogger may include any subjective state or status associated with the microblogger that can only be typically reported by the microblogger (e.g., generally cannot be directly reported by a third party or by a device). Such states including, for example, the subjective mental state of the microblogger (e.g., happiness, sadness, anger, tension, state of alertness, state of mental fatigue, jealousy, envy, and so forth), the subjective physical state of the microblogger (e.g., upset stomach, state of vision, state of hearing, pain, and so forth), and the subjective overall state of the microblogger (e.g., “good,” “bad,” state of overall wellness, overall fatigue, and so forth). Note that the term “subjective overall state” as will be used herein refers to those subjective states that may not fit neatly into the other two categories of subjective user states described above (e.g., subjective mental states and subjective physical states).

A third category of events that may be reported or posted through microblog entries include “subjective observations” made by the microblogger. A subjective observation is similar to subjective user states and may be any subjective opinion, thought, or evaluation relating to any external incidence (e.g., outward looking instead of inward looking as in the case of subjective user states). Thus, the difference between subjective user states and subjective observations is that subjective user states relates to self-described subjective descriptions of the user states of one's self while subjective observations relates to subjective descriptions or opinions regarding external events. Examples of subjective observations include, for example, a microblogger's perception about the subjective user state of another person (e.g., “he seems tired”), a microblogger's perception about another person's activities (e.g., “he drank too much yesterday”), a microblogger's perception about an external event (e.g., “it was a nice day today”), and so forth. Although microblogs are being used to provide a wealth of personal information, thus far they have been primarily limited to their use as a means for providing commentaries and for maintaining open diaries.

Another potential source for valuable but not yet fully exploited data is the data provided by sensing devices that are used to sense and/or monitor various aspects of everyday life. Currently there are a number of sensing devices that can detect and/or monitor various user related and nonuser related events. For example, there are presently a number of sensing devices that can sense various physical or physiological characteristics of a person or an animal (e.g., a pet or a livestock). Examples of such devices include commonly known and used monitoring devices such as blood pressure devices, heart rate monitors, blood glucose sensors (e.g., glucometers), respiration sensor devices, temperature sensors, and so forth. Other examples of devices that can monitor physical or physiological characteristics include more exotic and sophisticated devices such as functional magnetic resonance imaging (fMRI) device, functional Near Infrared (fNIR) devices, blood cell-sorting sensing device, and so forth. Many of these devices are becoming more compact and less expensive such that they are becoming increasingly accessible for purchase and/or self-use by the general public.

Other sensing devices may be used in order to sense and monitor activities of a person or an animal. These would include, for example, global positioning systems (GPS), pedometers, accelerometers, and so forth. Such devices are compact and can even be incorporated into, for example, a mobile communication device such a cellular telephone or on the collar of a pet. Other sensing devices for monitoring activities of individuals (e.g., users) may be incorporated into larger machines and may be used in order to monitor the usage of the machines by the individuals. These would include, for example, sensors that are incorporated into exercise machines, automobiles, bicycles, and so forth. Today there are even toilet monitoring devices that are available to monitor the toilet usage of individuals.

Other sensing devices are also available that can monitor general environmental conditions such as environmental temperature sensor devices, humidity sensor devices, barometers, wind speed monitors, water monitoring sensors, air pollution sensor devices (e.g., devices that can measure the amount of particulates in the air such as pollen, those that measure CO2 levels, those that measure ozone levels, and so forth). Other sensing devices may be employed in order to monitor the performance or characteristics of mechanical and/or electronic devices. All the above described sensing devices may provide useful data that may indicate objectively observable events (e.g., objective occurrences).

In accordance with various embodiments, robust methods, systems, and computer program products are provided to, among other things, acquiring events data indicating multiple events as originally reported by multiple sources including acquiring at least a first data indicating at least one reported event as originally reported by a user and a second data indicating at least a second reported event as originally reported by one or more sensing devices. The methods, systems, and computer program products may then develop a hypothesis based, at least in part, on the first data and the second data. In some embodiments, one or more actions may be executed based, at least in part, on the developed hypothesis. Examples of the types of actions that may be executed include, for example, the presentation of the developed hypothesis or advisories relating to the developed hypothesis. Other actions that may be executed include the prompting of mechanical and/or electronic devices to execute one or more operations based, at least in part, on the developed hypothesis.

The robust methods, systems, and computer program products may be employed in a variety of environments including, for example, social networking environments, blogging or microblogging environments, instant messaging (IM) environments, or any other type of environment that allows a user to, for example, maintain a diary.

In various implementations, a “hypothesis,” as referred to herein, may define one or more relationships or links between different types of events (i.e., event types) including at least a first event type (e.g., a type of event such as a particular type of subjective user state including, for example, a subjective mental state such as “happy”) and a second event type (e.g., another type of event such as a particular type of objective occurrence, for example, favorite sports team winning a game). In some cases, a hypothesis may be represented by an events pattern that may indicate spatial or sequential relationships between different event types (e.g., different types of events such as subjective user states and objective occurrences). In some embodiments, a hypothesis may be further defined by an indication of the soundness (e.g., strength) of the hypothesis.

Note that for ease of explanation and illustration, the following description will describe a hypothesis as defining, for example, the sequential or spatial relationship between two different event types, for example, a first event type and a second event type. However, those skilled in the art will recognize that such a hypothesis may also identify the relationships between three or more event types (e.g., a first event type, a second event type, a third event type, and so forth).

In some embodiments, a hypothesis may, at least in part, be defined or represented by an events pattern that indicates or suggests a spatial or a sequential (e.g., time/temporal) relationship between different event types. Such a hypothesis, in some cases, may also indicate the strength or weakness of the link between the different event types. That is, the strength or weakness (e.g., soundness) of the correlation between different event types may depend upon, for example, whether the events pattern repeatedly occurs and/or whether a contrasting events pattern has occurred that may contradict the hypothesis and therefore, weaken the hypothesis (e.g., an events pattern that indicates a person becoming tired after jogging for thirty minutes when a hypothesis suggests that a person will be energized after jogging for thirty minutes).

As briefly described above, a hypothesis may be represented by an events pattern that may indicate spatial or sequential (e.g., time or temporal) relationship or relationships between multiple event types. In some implementations, a hypothesis may merely indicate temporal sequential relationships between multiple event types that indicate the temporal relationships between multiple event types. In alternative implementations a hypothesis may indicate a more specific time relationship between multiple event types. For example, a sequential pattern may represent the specific pattern of events that occurs along a timeline that may indicate the specific time intervals between event types. In still other implementations, a hypothesis may indicate the spatial (e.g., geographical) relationships between multiple event types.

In various embodiments, the development of a hypothesis may be particularly useful to a user (e.g., a microblogger or a social networking user) that the hypothesis may or may not be directly associated with. That is, in some embodiments, a hypothesis may be developed that directly relates to a user. Such a hypothesis may relate to, for example, one or more subjective user states associated with the user, one or more activities associated with the user, or one or more characteristics associated with the user. In other embodiments, however, a hypothesis may be developed that may not be directly associated with a user. For example, a hypothesis may be developed that may be particularly associated with an acquaintance of the user, a pet, or a device operated or used by the user.

In some embodiments, the development of a hypothesis may assist a user in modifying his/her future behavior, while in other embodiments, such a hypothesis may be useful to third parties such as other users or nonusers, or even to advertisers in order to assist the advertisers in developing a more targeted marketing scheme. In still other situations, the development of a hypothesis relating to a user may help in the treatment of ailments associated with the user.

In some embodiments, a hypothesis may be developed (e.g., creating and/or further refinement of a hypothesis) by determining a pattern of reported events that repeatedly occurs and/or to compare similar or dissimilar reported pattern of events. For example, if a user such as a microblogger reports repeatedly that after each visit to a particular restaurant, the user always has an upset stomach, then a hypothesis may be created and developed that suggests that the user will get an upset stomach after visiting the particular restaurant. Note that such events may be based on reported data originally provided by two different sources, the user who reports having a stomach ache, and a sensing device such as a GPS device that reports data that indicates the user's visit to the restaurant just prior to the user reporting the occurrence of the stomach ache.

If, on the other hand, after developing such a hypothesis, the GPS device reports data that indicates that the user visited the same restaurant again but after the second visit the user reports feeling fine, then the reported data provided by the GPS device and the data provided by the user during and/or after the second visit may result in the weakening of the hypothesis (e.g., the second visit contradicts the hypothesis that a stomach ache is associated with visiting the restaurant). Alternatively, if after developing such a hypothesis, the GPS device and the user reports that in a subsequent visit to the restaurant, the user again got an upset stomach, then such reporting, as provided by both the user and the GPS device, may result in a confirmation of the soundness of the hypothesis.

In various embodiments, other types of hypothesis may be developed that may not be directly related to a user. For instance, a user (e.g., a person) and one or more sensing devices may report on the various characteristics, activities, and/or behaviors of a friend, a spouse, a pet, or even a mechanical or electronic device that the user may have an interest in. Based on such reported data, one or more hypothesis may be developed that may not be directly related to the user.

Thus, in accordance with various embodiments, robust methods, systems, and computer program products are provided that may be designed to, among other things, acquire events data indicating multiple events as originally reported by multiple sources including at least a first data indicating at least one reported event as originally reported by a user and a second data indicating at least a second reported event originally reported by one or more sensing devices. Based on the at least one reported event as indicated by the acquired first data and the at least second reported event as indicated by the second data, a hypothesis may be developed. In various embodiments, such a hypothesis may be related to, for example, the user, a third party (e.g., another user or nonuser, or a nonhuman living organism such as a pet or livestock), a mechanical and/or electronic device, the environment, or any other entity or item that may be relevant to the user. Note that the phrase “as originally reported” is used herein since the first data and the second data indicating the at least one reported event and the at least second reported event may be obtained from other sources other than their original sources (e.g., the user and the one or more sensing devices).

FIGS. 10-1a and 10-1b illustrate an example environment in accordance with various embodiments. In the illustrated environment, an exemplary system 10-100 may include at least a computing device 10-10 (see FIG. 10-1b). The computing device 10-10, which may be a server (e.g., network server) or a standalone device, may be designed to, among other things, acquire events data that indicates multiple reported events originally reported by different sources. For example, in some implementations, the events data to be acquired by the computing device 10-10 may include at least a first data 10-60 indicating at least one reported event as originally reported by a user 10-20* and a second data 10-61 indicating at least a second reported event as originally reported by one or more sensing devices 10-35*. In some embodiments, the computing device 10-10 may further acquire a third data 10-62 indicating at least a third reported event as originally reported by a third party 10-50 and/or a fourth data 10-63 indicating at least a fourth reported event as originally reported by another one or more sensing devices 10-35*.

Based at least on the reported events as indicated by the acquired first data 10-60 and the second data 10-61 (and in some cases, based further on the reported events indicated by the third data 10-62 and/or the fourth data 10-63), a hypothesis may be developed by the computing device 10-10. In some embodiments, one or more actions may be executed by the computing device 10-10 in response at least in part to the development of the hypothesis. In the following, “*” indicates a wildcard. Thus, references to user 10-20* may indicate a user 10-20a or a user 10-20b of FIGS. 10-1a and 10-1b. Similarly, references to sensing devices 10-35* may be a reference to sensing devices 10-35a or sensing devices 10-35b of FIGS. 10-1a and 10-1b.

As indicated earlier, in some embodiments, the computing device 10-10 may be a server while in other embodiments the computing device 10-10 may be a standalone device. In the case where the computing device 10-10 is a network server, the computing device 10-10 may communicate indirectly with a user 10-20a, one or more third parties 10-50, and one or more sensing devices 10-35a via wireless and/or wired network 10-40. The wireless and/or wired network 10-40 may comprise of, for example, a local area network (LAN), a wireless local area network (WLAN), personal area network (PAN), Worldwide Interoperability for Microwave Access (WiMAX), public switched telephone network (PTSN), general packet radio service (GPRS), cellular networks, and/or other types of wires or wired networks. In contrast, in embodiments where the computing device 10-10 is a standalone device, the computing device 10-10 may communicate directly at least with a user 10-20b (e.g., via a user interface 10-122) and one or more sensing devices 10-35b. In embodiments in which the computing device 10-10 is a standalone device, the computing device 10-10 may also communicate indirectly with one or more third parties 10-50 and one or more sensing devices 10-35a via a wireless and/or wired network 10-40.

In embodiments in which the computing device 10-10 is a network server (or simply “server”); the computing device 10-10 may communicate with a user 10-20a through a wireless and/or wired network 10-40 and via a mobile device 10-30. A network server, as will be described herein, may be in reference to a server located at a single network site or located across multiple network sites or a conglomeration of servers located at multiple network sites. The mobile device 10-30 may be a variety of computing/communication devices including, for example, a cellular phone, a personal digital assistant (PDA), a laptop, a desktop, or other types of computing/communication devices that can communicate with the computing device 10-10. In some embodiments, the mobile device 10-30 may be a handheld device such as a cellular telephone, a smartphone, a Mobile Internet Device (MID), an Ultra Mobile Personal Computer (UMPC), a convergent device such as a personal digital assistant (PDA), and so forth.

In embodiments in which the computing device 10-10 is a standalone device that may communicate directly with a user 10-20b, the computing device 10-10 may be any type of portable device (e.g., a handheld device) or non-portable device (e.g., desktop computer or workstation). For these embodiments, the computing device 10-10 may be any one of a variety of computing/communication devices including, for example, a cellular phone, a personal digital assistant (PDA), a laptop, a desktop, or other types of computing/communication devices. In some embodiments, in which the computing device 10-10 is a handheld device, the computing device 10-10 may be a cellular telephone, a smartphone, an MID, an UMPC, a convergent device such as a PDA, and so forth. In various embodiments, the computing device 10-10 may be a peer-to-peer network component device. In some embodiments, the computing device 10-10 and/or the mobile device 10-30 may operate via a Web 2.0 construct (e.g., Web 2.0 application 10-268).

In some implementations, in order to acquire the first data 10-60 and/or the second data 10-61, the computing device 10-10 may be designed to prompt the user 10-20* and/or the one or more sensing devices 10-35* (e.g., transmitting or indicating a request or an inquiry to the user 10-20* and/or the one or more sensing device 10-35*) to report occurrences of the first reported event and/or the second reported event as indicated by refs. 22 and 23. In alternative implementations, however, the computing device 10-10 may be designed to, rather than prompting the user 10-20* and/or the one or more sensors 10-35*, prompt one or more network devices such as the mobile device 10-30 and/or one or more network servers 10-36 in order to acquire the first data 10-60 and/or the second data 10-61. That is, in some cases, the user 10-20* and/or the one or more sensors 10-35* may already have previously provided the first data 10-60 and/or the second data 10-61 to one or more of the network devices (e.g., mobile device 10-30 and/or network servers 10-36).

Each of the reported events indicated by the first data 10-60 and/or the second data 10-61 may or may not be directly associated with a user 10-20*. For example, although each of the reported events may have been originally reported by the user 10-20* or by the one or more sensing devices 10-35*, the reported events (e.g., at least the one reported event as indicated by the first data 10-60 and the at least second reported event as indicated by the second data 10-61) may be, in some implementations, related or associated with one or more third parties (e.g., another user, a nonuser, or a nonhuman living organism such as a pet dog or livestock), one or more devices 10-55 (e.g., electronic and/or mechanical devices), or one or more aspects of the environmental (e.g., the quality of the local drinking water, local weather conditions, and/or atmospheric conditions). For example, when providing the first data 10-60, a user 10-20* may report on the perceptions made by the user 10-20* regarding the behavior or activities of a third party (e.g., another user or a pet) rather than the behavior or activities of the user 10-20* him or herself.

As previously described, a user 10-20* may at least be the original source for the at least one reported event as indicated by the first data 10-60. The at least one reported event as indicated by the first data 10-60 may indicate any one or more of a variety of possible events that may be reported by the user 10-20*. For example, and as will be explained in greater detail herein, the at least one reported event as indicated by the first data 10-60 may relate to at least a subjective user state (e.g., a subjective mental state, a subjective physical state, or a subjective overall state) of the user 10-20*, a subjective observation (e.g., the perceived subjective user state of a third party 10-50 as perceived by user 10-20*, the perceived activity of a third party 10-50 or the user 10-20* as perceived by the user 10-20*, the perceived performance or characteristic of a device 10-55 as perceived by the user 10-20*, the perceived occurrence of an external event as perceived by the user 10-20* such as the weather, and so forth), or an objective occurrence (e.g., objectively observable activities of the user 10-20*, a third party 10-50, or a device 10-55; objectively observable physical or physiological characteristics of the user 10-20* or a third party 10-50; objective observable external events including environmental events or characteristics of a device 10-55; and so forth).

In contrast, the at least second reported event as originally reported by one or more sensing devices 10-35* and indicated by the second data 10-61 may be related to an objective occurrence that may be objectively observed by the one or more sensing devices 10-35*. Examples of the type of objective occurrences that may be indicated by the second data 10-61 includes, for example, physical or physiological characteristics of the user 10-20* or a third party 10-50, selective activities of the user 10-20* or a third party 10-50, some external events such as environmental conditions (e.g., atmospheric temperature and humidity, air quality, and so forth), characteristics and/or operational activities of a device 10-35, geographic location of the user 10-20* or a third party 10-50, and so forth. FIGS. 10-1a and 10-1b show the one or more sensing device 10-35* detecting or sensing various aspects of a user 10-20*, one or more third parties 10-50, or one or more device 10-55 as indicated by ref 29. As will be described in greater detail herein, the one or more sensing devices 10-35* may include one or more different types of sensing devices (see FIG. 10-2d) that are capable of sensing objective occurrences.

After acquiring the events data including the first data 10-60 indicating the at least one reported event as originally reported by a user 10-20* and the second data 10-61 indicating the at least second reported event as originally reported by one or more sensing devices 10-35*, the computing device may be designed to develop a hypothesis. In various embodiments, the computing device 10-10 may develop a hypothesis by creating a new hypothesis based on the acquired events data and/or by refining an already existing hypothesis 10-80, which in some cases, may be stored in a memory 10-140.

After developing a hypothesis, the computing device 10-10 may be designed to execute one or more actions in response, at least in part, to the development of the hypothesis. One such action that may be executed is to present (e.g., transmit via a wireless and/or wired network 10-40 and/or indicate via user interface 10-122) one or more advisories 10-90 that may be related to the developed hypothesis. For example, in some implementations, the computing device 10-10 may present the developed hypothesis itself, or present an advisory such as an alert regarding reported past events or a recommendation for a future action to a user 10-20*, to one or more third parties 10-50, and/or to one or more remote network devices (e.g., network servers 10-36). In other implementations, or in the same implementations, the computing device 10-10 may prompt (e.g., as indicated by ref 25) one or more devices 10-55 (e.g., an automobile or a portion thereof, a household appliance or a portion thereof, a computing or communication device or a portion thereof, and so forth) to execute one or more operations.

Turning now to FIG. 10-1b, the computing device 10-10 may include one or more components and/or sub-modules. As those skilled in the art will recognize, these components and sub-modules may be implemented by employing hardware (e.g., in the form of circuitry such as application specific integrated circuit or ASIC, field programmable gate array or FPGA, or other types of circuitry), software, a combination of both hardware and software, or may be implemented by a general purpose computing device executing instructions included in a signal-bearing medium. In various embodiments, computing device 10-10 may include an events data acquisition module 10-102, a hypothesis development module 10-104, an action module 10-106, a network interface 10-120 (e.g., network interface card or NIC), a user interface 10-122 (e.g., a display monitor, a touchscreen, a keypad or keyboard, a mouse, an audio system including a microphone and/or speakers, an image capturing system including digital and/or video camera, and/or other types of interface devices), one or more applications 10-126 (e.g., a web 2.0 application 10-268, one or more communication applications 10-267 including, for example, a voice recognition application, and/or other applications), and/or memory 10-140. In some implementations, memory 10-140 may include an existing hypothesis 10-80 and/or historical data 10-81. Note that although not depicted, in various implementations, one or more copies of the one or more applications 10-126 may be included in memory 10-140.

The events data acquisition module 10-102 of FIG. 10-1b may be configured to, among other things, acquire events data indicating multiple reported events as reported by different sources. The events data to be acquired by the events data acquisition module 10-102 may include at least a first data 10-60 indicating at least one reported event as originally reported by a user 10-20* and a second data 10-61 indicating at least a second reported event as originally reported by one or more sensing devices 10-35*. In some implementations, the events data acquisition module 10-102 may be configured to further acquire a third data indicating at least a third reported event as originally reported by one or more third parties 10-50 and/or a fourth data indicating at least a fourth reported event as originally reported by another one or more sensing devices 10-35*.

Referring now to FIG. 10-2a illustrating particular implementations of the events data acquisition module 10-102 of the computing device 10-10 of FIG. 10-1b. The events data acquisition module 10-102 may include at least a first data acquisition module 10-201 configured to, among other things, acquire a first data 10-60 indicating at least one reported event that was originally reported by a user 10-20* and a second data acquisition module 10-215 configured to, among other things, acquire a second data 10-61 indicating at least a second reported event that was originally reported by one or more sensing devices 10-35*. In some implementations, the events data acquisition module 10-102 may further include a time element acquisition module 10-228 configured to acquire time elements associated with the reported events (e.g., the at least one reported event and the at least second reported event) and/or a spatial location indication acquisition module 10-234 configured to acquire spatial locations associated with reported events.

In various implementations, the first data acquisition module 10-201 may include one or more sub-modules. For example, in some implementations, such as in the case where the computing device 10-10 is a server, the first data acquisition module 10-201 may include a network interface reception module 10-202 configured to interface with a wireless and/or wired network 10-40 in order to receive the first data from a wireless and/or a wired network 10-40. In some implementations, such as when the computing device 10-10 is a standalone device, the first data acquisition module 10-201 may include a user interface reception module 10-204 configured to receive the first data 10-60 through a user interface 10-122.

In some instances, the first data acquisition module 10-201 may include a user prompting module 10-206 configured to prompt a user 10-20* to report occurrence of an event. Such an operation may be needed in some cases when, for example, the computing device 10-10 is missing data (e.g., first data 10-60 indicating the at least one reported event) that may be needed in order to develop a hypothesis (e.g., refining an existing hypothesis 10-80). In order to implement its operations, the user prompting module 10-206 may include a requesting module 10-208 that may be configured to indicate (e.g., via a user interface 10-122) or transmit (e.g., via a wireless and/or wired network 10-40) a request to a user 10-20* to report the occurrence of the event. The requesting module 10-208 may, in turn, include an audio requesting module 10-210 configured to audibly request (e.g., via one or more speakers) the user 10-20* to report the occurrence of the event and/or a visual requesting module 10-212 configured to visually request (e.g., via a display monitor) the user 10-20* to report the occurrence of the event. In some implementations, the first data acquisition module 10-201 may include a device prompting module 10-214 configured to, among other things, prompt a network device (e.g., a mobile device 10-30 or a network server 10-36) to provide the first data 10-60.

Turning now to the second data acquisition module, 10-215, the second data acquisition module 10-215 in various implementations may include one or more sub-modules. For example, in some implementations, the second data acquisition module 10-215 may include a network interface reception module 10-216 configured to interface with a wireless and/or wired network 10-40 in order to, for example, receive the second data 10-61 from at least one of a wireless and/or a wired network 10-40 and/or a sensing device reception module 10-218 configured to receive the second data 10-61 directly from the one or more sensing devices 10-35b. In various implementations, the second data acquisition module 10-215 may include a device prompting module 10-220 configured to prompt the one or more sensing devices 10-35* to provide the second data 10-61 (e.g., to report the second reported event).

In order to implement its functional operations, the device prompting module 10-220 in some implementations may further include one or more sub-modules including a sensing device directing/instructing module 10-222 configured to direct or instruct the one or more sensing devices 10-35* to provide the second data 10-61 (e.g., to report the second reported event). In the same or different implementations, the device prompting module 10-220 may include a sensing device configuration module 10-224 designed to configure the one or more sensing devices 10-35* to provide the second data 10-61 (e.g., to report the second reported event). In the same or different implementations, the device prompting module 10-220 may include a sensing device requesting module 10-226 configured to request the one or more sensing devices 10-35* to provide the second data 10-61 (e.g., to report the second reported event).

In various implementations, the time element acquisition module 10-228 of the events data acquisition module 10-102 may include one or more sub-modules. For example, in some implementations, the time element acquisition module 10-228 may include a time stamp acquisition module 10-230 configured to acquire a first time stamp associated with the at least one reported event and a second time stamp associated with the at least second reported event. In the same or different implementations, the time element acquisition module 10-228 may include a time interval indication acquisition module 10-232 configured to acquire an indication of a first time interval associated with the at least one reported event and an indication of second time interval associated with the at least second reported event.

Referring back to FIG. 10-1b, the hypothesis development module 10-104 of FIG. 10-1b may be configured to, among other things, develop a hypothesis based, at least in part, on the first data 10-60 and the second data 10-61 (e.g., the at least one reported event and the at least second reported event) acquired by the events data acquisition module 10-102. In some embodiments, the hypothesis development module 10-104 may develop a hypothesis by creating a new hypothesis based, at least in part, on the acquired first data 10-60 (e.g., at least one reported event as indicated by the first data 10-60) and the second data 10-61 (e.g., at least a second reported event as indicated by the second data 10-61). In other embodiments, however, a hypothesis may be developed by refining an existing hypothesis 10-80 based, at least in part, on the acquired first data 10-60 (e.g., at least one reported event as indicated by the first data 10-60) and the second data 10-61 (e.g., at least a second reported event as indicated by the second data 10-61).

FIG. 10-2b illustrates particular implementations of the hypothesis development module 10-104 of FIG. 10-1b. In various implementations, the hypothesis development module 10-104 may include a hypothesis creation module 10-236 configured to create a hypothesis based, at least in part, on the first data 10-60 (e.g., at least one reported event as indicated by the first data 10-60) and the second data 10-61 (e.g., at least a second reported event as indicated by the second data 10-61) acquired by the events data acquisition module 10-102. In the same or different implementations, the hypothesis development module 10-104 may include an existing hypothesis refinement module 10-244 configured to refine an existing hypothesis 10-80 based, at least in part, on the at least one reported event (e.g., as indicated by the first data 10-60) and the at least reported event (e.g., as indicated by the second data 10-61).

The hypothesis creation module 10-236 may include one or more sub-modules in various implementations. For example, in some implementations, the hypothesis creation module 10-236 may include an events pattern determination module 10-238 configured to determine an events pattern based, at least in part, on occurrence of the first reported event and occurrence of the second reported event. The determined events pattern may then facilitate the hypothesis creation module 10-236 in creating a hypothesis. In some implementations, the events pattern determination module 10-238, in order to for example facilitate the hypothesis creation module 10-236 to create a hypothesis, may further include a sequential events pattern determination module 10-240 configured to determine a sequential events pattern based, at least in part, on the time or temporal occurrence of the at least one reported event and the time or temporal occurrence of the at least second reported event and/or a spatial events pattern determination module 10-242 configured to determine a spatial events pattern based, at least in part, on the spatial occurrence of the at least one reported event and the spatial occurrence of the at least second reported event.

The existing hypothesis refinement module 10-244, in various implementations, may also include one or more sub-modules. For example, in various implementations, the existing hypothesis refinement module 10-244 may include an events pattern determination module 10-246 configured to, for example, facilitate the existing hypothesis refinement module 10-244 in refining the existing hypothesis 10-80 by determining at least an events pattern based, at least in part, on occurrence of the at least one reported event and occurrence of the at least second reported event. In some implementations, the events pattern determination module 10-246 may further include a sequential events pattern determination module 10-248 configured to determine a sequential events pattern based, at least in part, on the time or temporal occurrence of the at least one reported event and the time or temporal occurrence of the at least second reported event and/or a spatial events pattern determination module 10-250 configured to determine a spatial events pattern based, at least in part, on the spatial occurrence of the at least one reported event and the spatial occurrence of the at least second reported event. Note that in cases where both the hypothesis creation module 10-236 and the existing hypothesis refinement module 10-244 are present in the hypothesis development module 10-104, one or more of the events pattern determination module 10-246, the sequential events pattern determination module 10-248, and the spatial events pattern determination module 10-250 of the existing hypothesis refinement module 10-244 may be the same modules as the events pattern determination module 10-238, the sequential events pattern determination module 10-240, and the spatial events pattern determination module 10-242, respectively, of the hypothesis creation module 10-236.

In some cases, the existing hypothesis refinement module 10-244 may include a support determination module 10-252 configured to determine whether an events pattern, as determined by the events pattern determination module 10-246, supports an existing hypothesis 10-80. In some implementations, the support determination module may further include a comparison module 10-254 configured to compare the determined events pattern (e.g., as determined by the events pattern determination module 10-246) with an events pattern associated with the existing hypothesis 10-80 to facilitate in the determination as to whether the determined events pattern supports the existing hypothesis 10-80.

In some cases, the existing hypothesis refinement module 10-244 may include a soundness determination module 10-256 configured to determine soundness of an existing hypothesis 10-80 based, at least in part, on a comparison made by the comparison module 10-254. In some cases, the existing hypothesis refinement module 10-244 may include a modification module 10-258 configured to modify an existing hypothesis 10-80 based, at least in part, on a comparison made by the comparison module 10-254.

Referring back to FIG. 10-1b, the action execution module 10-106 of the computing device 10-10 may be designed to execute one or more actions (e.g., operations) in response, at least in part, to the development of a hypothesis by the hypothesis development module 10-104. The one or more actions to be executed may include, for example, presentation (e.g., transmission or indication) of one or more advisories related to the hypothesis developed by the hypothesis development module 10-104 and/or prompting one or more local or remote devices 10-55 to execute one or more actions or operations.

Referring now to FIG. 10-2c illustrating particular implementations of the action execution module 10-106. In various embodiments, the action execution module 10-106 may include one or more sub-modules. For example, in various implementations, the action execution module 10-106 may include an advisory presentation module 10-260 configured to present one or more advisories relating to a hypothesis developed by, for example, the hypothesis development module 10-104 and/or a device prompting module 10-277 configured to prompt (e.g., as indicated by ref 25) one or more devices 10-55 to execute one or more operations (e.g., actions) based, at least in part, on a hypothesis developed by, for example, the hypothesis development module 10-104.

The advisory presentation module 10-260, in turn, may further include one or more additional sub-modules. For instance, in some implementations, the advisory presentation module 10-260 may include an advisory indication module 10-262 configured to indicate, via a user interface 10-122, the one or more advisories related to the hypothesis developed by, for example, the hypothesis development module 10-104. In the same or different implementations, the advisory presentation module 10-260 may include an advisory transmission module 10-264 configured to transmit, via at least one of a wireless network or a wired network, the one or more advisories related to the hypothesis developed by, for example, the hypothesis development module 10-104.

In the same or different implementations, the advisory presentation module 10-260 may include a hypothesis presentation module 10-266 configured to, among other things, present (e.g., either transmit or indicate) at least a form of a hypothesis developed by, for example, the hypothesis development module 10-104. In various implementations, the hypothesis presentation module 10-266 may include one or more additional sub-modules. For example, in some implementations, the hypothesis presentation module 10-266 may include an event types relationship presentation module 10-268 configured to present an indication of a relationship between at least a first event type and at least a second event type as referenced by the hypothesis developed by, for example, the hypothesis development module 10-104.

In the same or different implementations, the hypothesis presentation module 10-266 may include a hypothesis soundness presentation module 10-270 configured to present an indication of soundness of the hypothesis developed by, for example, the hypothesis development module 10-104. In the same or different implementations, the hypothesis presentation module 10-266 may include a temporal/specific time relationship presentation module 10-271 configured to present an indication of a temporal or specific time relationship between the at least first event type and the at least second event type as referenced by the hypothesis developed by, for example, the hypothesis development module 10-104. In the same or different implementations, the hypothesis presentation module 10-266 may include a spatial relationship presentation module 10-272 configured to present an indication of a spatial relationship between the at least first event type and the at least second event type as referenced by the hypothesis developed by, for example, the hypothesis development module 10-104.

In various implementations, the advisory presentation module 10-260 may include a prediction presentation module 10-273 configured to present an advisory relating to a predication of one or more future events based, at least in part, on the hypothesis developed by, for example, the hypothesis development module 10-104. In the same or different implementations, the advisory presentation module 10-260 may include a recommendation presentation module 10-274 configured to present a recommendation for a future course of action based, at least in part, on the hypothesis developed by, for example, the hypothesis development module 10-104. In some implementations, the recommendation presentation module 10-274 may further include a justification presentation module 10-275 configured to present a justification for the recommendation presented by the recommendation presentation module 10-274.

In various implementations, the advisory presentation module 10-260 may include a past events presentation module 10-276 configured to present an indication of one or more past events based, at least in part, on the hypothesis developed by, for example, the hypothesis development module 10-104.

The device prompting module 10-277 in various embodiments may include one or more sub-modules. For example, in some implementations, the device prompting module 10-277 may include a device instruction module 10-278 configured to instruct one or more devices 10-55 to execute one or more operations (e.g., actions) based, at least in part, on the hypothesis developed by, for example, the hypothesis development module 10-104. In the same or different implementations, the device prompting module 10-277 may include a device activation module 10-279 configured to activate one or more devices 10-55 to execute one or more operations (e.g., actions) based, at least in part, on the hypothesis developed by, for example, the hypothesis development module 10-104. In the same or different implementations, the device prompting module 10-277 may include a device configuration module 10-280 designed to configure one or more devices 10-55 to execute one or more operations (e.g., actions) based, at least in part, on the hypothesis developed by, for example, the hypothesis development module 10-104.

Turning now to FIG. 10-2d illustrating particular implementations of the one or more sensing devices 10-35* (e.g., one or more sensing devices 10-35a and/or one or more sensing devices 10-35b). In some implementations, the one or more sensing devices 10-35* may include one or more physiological sensor devices 10-281 designed to sense one or more physical or physiological characteristics of a subject such as a user 10-20* or a third party 10-50 (e.g., another user, a nonuser, or a nonhuman living organism such as a pet or livestock). In various implementations, the one or more physiological sensor devices 10-281 may include, for example, a heart rate sensor device 10-282, blood pressure sensor device 10-283, a blood glucose sensor device 10-284, a functional magnetic resonance imaging (fMRI) device 10-285, a functional near-infrared (fNIR) device 10-286, a blood alcohol sensor device 10-287, a temperature sensor device 10-288 (e.g., to measure a temperature of the subject), a respiration sensor device 10-289, a blood cell-sorting sensor device 10-322 (e.g., to sort between different types of blood cells), and/or other types of devices capable of sensing one or more physical or physiological characteristics of a subject (e.g., a user 10-20*).

In the same or different implementations, the one or more sensing devices 10-35* may include one or more imaging system devices 10-290 for capturing various types of images of a subject (e.g., a user 10-20* or a third party 10-50). Examples of such imaging system devices 10-290 include, for example, a digital or video camera, an x-ray machine, an ultrasound device, and so forth. Note that in some instances, the one or more imaging system devices 10-290 may also include an fMRI device 10-285 and/or an fNIR device 10-286.

In the same or different implementations, the one or more sensing devices 10-35* may include one or more user activity sensing devices 10-291 designed to sense or monitor one or more user activities of a subject (e.g., a user 10-20* or a third party 10-50 such as another person or a pet or livestock). For example, in some implementations, the user activity sensing devices 10-291 may include a pedometer 10-292, an accelerometer 10-293, an image capturing device 10-294 (e.g., digital or video camera), a toilet monitoring device 10-295, an exercise machine sensor device 10-296, and/or other types of sensing devices capable of sensing a subject's activities.

In the same or different implementations, the one or more sensing devices 10-35* may include a global position system (GPS) 10-297 to determine one or more locations of a subject (e.g., a user 10-20* or a third party 10-50 such as another user or an animal), an environmental temperature sensor device 10-298 designed to sense or measure environmental (e.g. atmospheric) temperature, an environmental humidity sensor device 10-299 designed to sense or measure environmental (e.g. atmospheric) humidity level, an environmental air pollution sensor device 10-320 to measure or sense various gases such as CO2, ozone, xenon, and so forth in the atmosphere or to measure particulates (e.g., pollen) in the atmosphere, and/or other devices for measuring or sensing various other characteristics of the environment (e.g., a barometer, a wind speed sensor, a water quality sensing device, and so forth).

In various implementations, the computing device 10-10 of FIG. 10-1b may include one or more applications 10-126. The one or more applications 10-126 may include, for example, one or more communication applications 10-267 (e.g., text messaging application, instant messaging application, email application, voice recognition system, and so forth) and/or Web 2.0 application 10-268 to facilitate in communicating via, for example, the World Wide Web. In some implementations, copies of the one or more applications 10-126 may be stored in memory 10-140.

In various implementations, the computing device 10-10 may include a network interface 10-120, which may be a device designed to interface with a wireless and/or wired network 10-40. Examples of such devices include, for example, a network interface card (NIC) or other interface devices or systems for communicating through at least one of a wireless network or wired network 10-40. In some implementations, the computing device 10-10 may include a user interface 10-122. The user interface 10-122 may comprise any device that may interface with a user 10-20b. Examples of such devices include, for example, a keyboard, a display monitor, a touchscreen, a microphone, a speaker, an image capturing device such as a digital or video camera, a mouse, and so forth.

The computing device 10-10 may include a memory 10-140. The memory 10-140 may include any type of volatile and/or non-volatile devices used to store data. In various implementations, the memory 10-140 may comprise, for example, a mass storage device, a read only memory (ROM), a programmable read only memory (PROM), an erasable programmable read-only memory (EPROM), random access memory (RAM), a flash memory, a synchronous random access memory (SRAM), a dynamic random access memory (DRAM), and/or other memory devices. In various implementations, the memory 10-140 may store an existing hypotheses 10-80 and/or historical data 10-81 (e.g., historical data including, for example, past events data or historical events patterns related to a user 10-20*, related to a subgroup of the general population that the user 10-20 belongs to, or related to the general population).

The various features and characteristics of the components, modules, and sub-modules of the computing device 10-10 presented thus far will be described in greater detail with respect to the processes and operations to be described herein.

FIG. 10-3 illustrates an operational flow 10-300 representing example operations related to, among other things, acquisition of events data from multiple sources including at least a first data indicating at least one reported event as originally reported by a user and a second data indicating at least a second reported event as originally reported by one or more sensing devices, and the development of a hypothesis based, at least in part, on the acquired first and second data. In some embodiments, the operational flow 10-300 may be executed by, for example, the computing device 10-10 of FIG. 10-1b, which may be a server or a standalone device.

In FIG. 10-3 and in the following figures that include various examples of operational flows, discussions and explanations may be provided with respect to the above-described exemplary environment of FIGS. 10-1a and 10-1b, and/or with respect to other examples (e.g., as provided in FIGS. 10-2a to 10-2c) and contexts. However, it should be understood that the operational flows may be executed in a number of other environments and contexts, and/or in modified versions of FIGS. 10-1a, 10-1b, and 10-2a to 10-2d. Also, although the various operational flows are presented in the sequence(s) illustrated, it should be understood that the various operations may be performed in different sequential orders other than those which are illustrated, or may be performed concurrently.

Further, in the following figures that depict various flow processes, various operations may be depicted in a box-within-a-box manner. Such depictions may indicate that an operation in an internal box may comprise an optional example embodiment of the operational step illustrated in one or more external boxes. However, it should be understood that internal box operations may be viewed as independent operations separate from any associated external boxes and may be performed in any sequence with respect to all other illustrated operations, or may be performed concurrently.

In any event, after a start operation, the operational flow 10-300 may move to a data acquisition operation 10-302 for acquiring a first data indicating at least one reported event as originally reported by a user and a second data indicating at least a second reported event as originally reported by one or more sensing devices. For instance, the events data acquisition module 10-102 of the computing device 10-10 acquiring a first data 10-60 (e.g., in the form of a blog entry, a status report, an electronic message, or a diary entry) indicating at least one reported event (e.g., a subjective user state, a subjective observation, or an objective occurrence) as originally reported by a user 10-20* and a second data 10-61 indicating at least a second reported event (e.g., objective occurrence) as originally reported by one or more sensing devices 10-35*.

Next, operational flow 10-300 may include hypothesis development operation 10-304 for developing a hypothesis based, at least in part, on the first data and the second data. For instance, the hypothesis development module 10-104 of the computing device 10-10 developing a hypothesis (e.g., creating a new hypothesis or refining an existing hypothesis) based, at least in part, on the first data 10-60 and the second data 10-61. Note that in the following description and for ease of illustration and understanding the hypothesis to be developed through the hypothesis development operation 10-304 may be described as linking together two types of events (i.e., event types). However, those skilled in the art will recognize that such a hypothesis 10-80 may alternatively relate to the association of three or more types of events in various implementations.

In various implementations, the first data 10-60 to be acquired during the data acquisition operation 10-302 of FIG. 10-3 may be acquired through various means in various forms. For example, in some implementations, the data acquisition operation 10-302 may include an operation 10-402 for receiving the first data from at least one of a wireless network and a wired network as depicted in FIG. 10-4a. For instance, when the computing device 10-10 of FIG. 10-1b is a server, the network interface reception module 10-202 of the computing device 10-10 may receive the first data 10-60 from at least one of a wireless network and a wired network 10-40.

In some alternative implementations, the data acquisition operation 10-302 may include an operation 10-403 for receiving the first data via a user interface as depicted in FIG. 10-4a. For instance, when the computing device 10-10 is a standalone device, such as a handheld device, the user interface reception module 10-204 of the computing device 10-10 may receive the first data 10-60 via a user interface 10-122 (e.g., a touch screen, a microphone, a mouse, and/or other input devices).

In the same or different implementations, the data acquisition operation 10-302 may include an operation 10-404 for prompting the user to report an occurrence of an event as depicted in FIG. 10-4a. For instance, when the computing device 10-10 is either a server or a standalone device, the user prompting module 10-206 of the computing device 10-10 prompting (as indicated by ref. 22 in FIGS. 10-1a and 10-1b) the user 10-20* (e.g., by generating a simple “ping,” or generating a more specific request) to report an occurrence of an event (e.g., the reported event may be a subjective user state, a subjective observation, or an objective occurrence).

In various implementations, operation 10-404 may comprise an operation 10-405 for requesting the user to report the occurrence of the event as depicted in FIG. 10-4a. For instance, the requesting module 10-208 of the computing device 10-10 requesting (e.g., transmitting a request or indicating a request via the user interface 10-122) the user 10-20* to report the occurrence of the event.

In some implementations, operation 10-405 may further comprise an operation 10-406 for requesting audibly the user to report the occurrence of the event as depicted in FIG. 10-4a. For instance, audio requesting module 10-210 of the computing device 10-10 requesting audibly (e.g., via the user interface 10-122 in the case where the computing device 10-10 is a standalone device or via a speaker system of the mobile device 10-30 in the case where the computing device 10-10 is a server) the user 10-20* to report the occurrence of the event.

In some implementations, operation 10-405 may further comprise an operation 10-407 for requesting visually the user to report the occurrence of the event as depicted in FIG. 10-4a. For instance, visual requesting module 10-212 of the computing device 10-10 requesting visually (e.g., via the user interface 10-122 in the case where the computing device 10-10 is a standalone device or via a display system of the mobile device 10-30 in the case where the computing device 10-10 is a server) the user 10-20* to report the occurrence of the event.

In some implementations, the data acquisition operation 10-302 may include an operation 10-408 for prompting a network device to provide the first data as depicted in FIG. 10-4a. For instance, the device prompting module 10-214 of the computing device 10-10 prompting (as indicated by ref. 24 in FIG. 10-1a) a network device such as the mobile device 10-30 or a network server 10-36 to provide the first data 10-60.

The first data 10-60 to be acquired through the data acquisition operation 10-302 may be in a variety of different forms. For example, in some implementations, the data acquisition operation 10-302 may include an operation 10-409 for acquiring, via one or more electronic entries, a first data indicating at least one reported event as originally reported by the user as depicted in FIG. 10-4a. For instance, the first data acquisition module 10-201 of the computing device 10-10 acquiring (e.g., acquiring through the user interface 10-122 or receiving through the wireless and/or wired network 10-40) a first data 10-60 indicating at least one reported event as originally reported by the user 10-20*.

In some implementations, operation 10-409 may comprise an operation 10-410 for acquiring, via one or more blog entries, a first data indicating at least one reported event as originally reported by the user as depicted in FIG. 10-4a. For instance, the first data acquisition module 10-201 of the computing device 10-10 acquiring (e.g., receiving through the wireless and/or wired network 10-40), via one or more blog entries (e.g., microblog entries), a first data 10-60 indicating at least one reported event as originally reported by the user 10-20a.

In some implementations, operation 10-409 may include an operation 10-411 for acquiring, via one or more status report entries, a first data indicating at least one reported event as originally reported by the user as depicted in FIG. 10-4a. For instance, the first data acquisition module 10-201 of the computing device 10-10 acquiring (e.g., receiving through the wireless and/or wired network 10-40), via one or more status report entries, a first data 10-60 indicating at least one reported event as originally reported by the user 10-20a.

In some implementations, operation 10-409 may include an operation 10-412 for acquiring, via one or more electronic messages, a first data indicating at least one reported event originally reported by the user as depicted in FIG. 10-4a. For instance, the first data acquisition module 10-201 of the computing device 10-10 acquiring (e.g., receiving through the wireless and/or wired network 10-40), via one or more status electronic messages (e.g., text messages, email messages, IM messages, and so forth), a first data 10-60 indicating at least one reported event as originally reported by the user 10-20a.

In some implementations, operation 10-409 may include an operation 10-413 for acquiring via one or more diary entries, a first data indicating at least one reported event originally reported by the user as depicted in FIG. 10-4a. For instance, the first data acquisition module 10-201 of the computing device 10-10 acquiring (e.g., acquiring through the user interface 10-122), via one or more diary entries, a first data 10-60 indicating at least one reported event as originally reported by the user 10-20b.

As will be further described herein, the first data 10-60 acquired during the data acquisition operation 10-302 of FIG. 10-3 may indicate a variety of reported events. For example, in various implementations, the data acquisition operation 10-302 may include an operation 10-414 for acquiring a first data indicating at least one subjective user state of the user as originally reported by the user as depicted in FIG. 10-4b. For instance, the first data acquisition module 10-201 of the computing device 10-10 acquiring a first data 10-60 indicating at least one subjective user state (e.g., fatigue, happiness, sadness, nauseous, alertness, energetic, and so forth) of the user 10-20* as originally reported by the user 10-20*.

Various types of subjective user states may be indicated by the first data 10-60 acquired through operation 10-414. For example, in some implementations, operation 10-414 may include an operation 10-415 for acquiring a first data indicating at least one subjective mental state of the user as originally reported by the user as depicted in FIG. 10-4b. For instance, the first data acquisition module 10-201 of the computing device 10-10 acquiring a first data 10-60 indicating at least one subjective mental state (e.g., fatigue, happiness, sadness, nauseous, alertness, energetic, and so forth) of the user 10-20* as originally reported by the user 10-20*.

In some implementations, operation 10-414 may include an operation 10-416 for acquiring a first data indicating at least one subjective physical state of the user as originally reported by the user as depicted in FIG. 10-4b. For instance, the first data acquisition module 10-201 of the computing device 10-10 acquiring a first data 10-60 indicating at least one subjective physical state (e.g., headache, stomach ache, sore back, sore or stiff ankle, overall fatigue, blurry vision, and so forth) of the user 10-20* as originally reported by the user 10-20*.

In some implementations, operation 10-414 may include an operation 10-417 for acquiring a first data indicating at least one subjective overall state of the user as originally reported by the user as depicted in FIG. 10-4b. For instance, the first data acquisition module 10-201 of the computing device 10-10 acquiring a first data 10-60 indicating at least one subjective overall state (e.g., “good,” “bad,” “well,” “available,” and so forth) of the user 10-20* as originally reported by the user 10-20*.

In various alternative implementations, the first data 10-60 acquired during the data acquisition operation 10-302 of FIG. 10-3 may indicate at least one subjective observation. For example, in some implementations, the data acquisition operation 10-302 of FIG. 10-3 may include an operation 10-418 for acquiring a first data indicating at least one subjective observation made by the user as depicted in FIG. 10-4b. For instance, the first data acquisition module 10-201 of the computing device 10-10 acquiring a first data 10-60 indicating at least one subjective observation (e.g., a subjective observation regarding an external event, a subjective observation regarding an activity executed by the user or by a third party, a subjective observation regarding the subjective user state of a third party as perceived by the user 10-20*, and so forth) made by the user 10-20*.

A variety of subjective observations may be indicated by the first data 10-60 acquired during operation 10-418. For example, in various implementations, operation 10-418 may include an operation 10-419 for acquiring a first data indicating at least one subjective observation made by the user regarding a third party as depicted in FIG. 10-4b. For instance, the first data acquisition module 10-201 of the computing device 10-10 acquiring a first data 10-60 indicating at least one subjective observation made by the user 10-20* regarding a third party 10-50 (e.g., subjective user state of the third party 10-50 or demeanor of the third party 10-50 as perceived by the user 10-20*). A third party 10-50, as will be described herein, may be in reference to a person such as another user or a non-user, or a non-human living creature or organism such as a pet or livestock.

As will be further described herein, various types of subjective observations may be made by the user 10-20* regarding a third party. For example, in various implementations, operation 10-419 may include an operation 10-420 for acquiring a first data indicating at least one subjective observation made by the user regarding subjective user state of the third party as perceived by the user as depicted in FIG. 10-4b. For instance, the first data acquisition module 10-201 of the computing device 10-10 acquiring a first data 10-60 indicating at least one subjective observation made by the user 10-20* regarding subjective user state (e.g., subjective mental state, subjective physical state, or subjective overall state) of the third party 10-50 as perceived by the user 10-20*.

In some implementations, operation 10-420 may include an operation 10-421 for acquiring a first data indicating at least one subjective observation made by the user regarding subjective mental state of the third party as perceived by the user as depicted in FIG. 10-4b. For instance, the first data acquisition module 10-201 of the computing device 10-10 acquiring a first data 10-60 indicating at least one subjective observation made by the user 10-20* regarding subjective mental state (e.g., distracted, indifferent, angry, happy, nervous, alert, and so forth) of the third party 10-50 as perceived by the user 10-20*.

In some implementations, operation 10-420 may include an operation 10-422 for acquiring a first data indicating at least one subjective observation made by the user regarding subjective physical state of the third party as perceived by the user as depicted in FIG. 10-4b. For instance, the first data acquisition module 10-201 of the computing device 10-10 acquiring a first data 10-60 indicating at least one subjective observation made by the user 10-20* regarding subjective physical state (e.g., in pain) of the third party 10-50 as perceived by the user 10-20*.

In some implementations, operation 10-420 may include an operation 10-423 for acquiring a first data indicating at least one subjective observation made by the user regarding subjective overall state of the third party as perceived by the user as depicted in FIG. 10-4b. For instance, the first data acquisition module 10-201 of the computing device 10-10 acquiring a first data 10-60 indicating at least one subjective observation made by the user 10-20* regarding subjective overall state (e.g., “available”) of the third party 10-50 as perceived by the user 10-20*.

In various implementations, operation 10-419 of FIG. 10-4b may include an operation 10-424 for acquiring a first data indicating at least one subjective observation made by the user regarding one or more activities performed by the third party as perceived by the user as depicted in FIG. 10-4c. For instance, the first data acquisition module 10-201 of the computing device 10-10 acquiring a first data 10-60 indicating at least one subjective observation made by the user 10-20* regarding one or more activities (e.g., demeanor or facial expression) performed by the third party 10-50 (e.g., another user or a pet) as perceived by the user 10-20*.

In various implementations, operation 10-418 of FIG. 10-4c may include an operation 10-425 for acquiring a first data indicating at least one subjective observation made by the user regarding occurrence of one or more external activities as depicted in FIG. 10-4c. For instance, the first data acquisition module 10-201 of the computing device 10-10 acquiring a first data 10-60 indicating at least one subjective observation made by the user 10-20* regarding occurrence of one or more external activities (e.g., “my car is poorly running”).

In some implementations, operation 10-418 may include an operation 10-426 for acquiring a first data indicating at least one subjective observation made by the user relating to an external event as depicted in FIG. 10-4c. For instance, the first data acquisition module 10-201 of the computing device 10-10 acquiring a first data 10-60 indicating at least one subjective observation made by the user 10-20* relating to an external event (e.g., “it is a hot day”).

The data acquisition operation 10-302 of FIG. 10-3 may acquire a first data that indicates at least one objective occurrence. For example, in various implementations, the data acquisition operation 10-302 may include an operation 10-427 for acquiring a first data indicating at least one objective occurrence as originally reported by the user as depicted in FIG. 10-4d. For instance, the first data acquisition module 10-201 of the computing device 10-10 acquiring a first data 10-60 indicating at least one objective occurrence (e.g., an activity executed by the user 10-20* or by a third party 10-50*) as originally reported by the user 10-20*.

In some cases, operation 10-427 may involve acquiring a first data 10-60 that indicates an objective occurrence related to the user 10-20*. For example, in various implementations, operation 10-427 may include an operation 10-428 for acquiring a first data indicating at least one activity executed by the user as originally reported by the user as depicted in FIG. 10-4d. For instance, the first data acquisition module 10-201 of the computing device 10-10 acquiring a first data 10-60 indicating at least one activity (e.g., an activity participated by the user 10-20* such as eating or exercising) executed by the user 10-20* as originally reported by the user 10-20*.

In some instances, the first data 10-60 to be acquired may indicate an activity involving the consumption of an item by the user 10-20*. For example, in some implementations, operation 10-428 may comprise an operation 10-429 for acquiring a first data indicating at least a consumption of an item by the user as originally reported by the user as depicted in FIG. 10-4d. For instance, the first data acquisition module 10-201 of the computing device 10-10 acquiring a first data 10-60 indicating at least a consumption of an item (e.g., alcoholic beverage) by the user 10-20* as originally reported by the user 10-20*.

In these implementations, the first data 10-60 to be acquired may indicate the user 10-20* consuming any one of a variety of items. For example, in some implementations, operation 10-429 may include an operation 10-430 for acquiring a first data indicating at least a consumption of a food item by the user as originally reported by the user as depicted in FIG. 10-4d. For instance, the first data acquisition module 10-201 of the computing device 10-10 acquiring a first data 10-60 indicating at least a consumption of a food item (e.g., spicy food) by the user 10-20* as originally reported by the user 10-20*.

In some implementations, operation 10-429 may include an operation 10-431 for acquiring a first data indicating at least a consumption of a medicine by the user as originally reported by the user as depicted in FIG. 10-4d. For instance, the first data acquisition module 10-201 of the computing device 10-10 acquiring a first data 10-60 indicating at least a consumption of a medicine (e.g., aspirin) by the user 10-20* as originally reported by the user 10-20*.

In some implementations, operation 10-429 may include an operation 10-432 for acquiring a first data indicating at least a consumption of a nutraceutical by the user as originally reported by the user as depicted in FIG. 10-4d. For instance, the first data acquisition module 10-201 of the computing device 10-10 acquiring a first data 10-60 indicating at least a consumption of a nutraceutical (e.g., Kava, Ginkgo, Sage, and so forth) by the user 10-20* as originally reported by the user 10-20*.

The first data 10-60 acquired in operation 10-428 may indicate other types of activities executed by the user 10-20* in various alternative implementations. For example, in some implementations, operation 10-428 may include an operation 10-433 for acquiring a first data indicating at least a social or leisure activity executed by the user as originally reported by the user as depicted in FIG. 10-4d. For instance, the first data acquisition module 10-201 of the computing device 10-10 acquiring a first data 10-60 indicating at least a social or leisure activity (e.g., eating dinner with friends or family or playing golf) executed by the user 10-20* as originally reported by the user 10-20*.

In some implementations, operation 10-428 may include an operation 10-434 for acquiring a first data indicating at least a work activity executed by the user as originally reported by the user as depicted in FIG. 10-4d. For instance, the first data acquisition module 10-201 of the computing device 10-10 acquiring a first data 10-60 indicating at least a work activity (e.g., arriving at work at 6 AM) executed by the user 10-20* as originally reported by the user 10-20*.

In some implementations, operation 10-428 may include an operation 10-435 for acquiring a first data indicating at least an exercise activity executed by the user as originally reported by the user as depicted in FIG. 10-4d. For instance, the first data acquisition module 10-201 of the computing device 10-10 acquiring a first data 10-60 indicating at least an exercise activity (e.g., walking, jogging, lifting weights, swimming, aerobics, treadmills, and so forth) executed by the user 10-20* as originally reported by the user 10-20*.

In some implementations, operation 10-428 may include an operation 10-436 for acquiring a first data indicating at least a learning or educational activity executed by the user as originally reported by the user as depicted in FIG. 10-4d. For instance, the first data acquisition module 10-201 of the computing device 10-10 acquiring a first data 10-60 indicating at least a learning or educational activity (e.g., reading, attending a class or lecture, and so forth) executed by the user 10-20* as originally reported by the user 10-20*.

In various implementations, the first data 10-60 that may be acquired through operation 10-427 of FIG. 10-4d may indicate other types of activities or events that may not be directly related to the user 10-20*. For example, in various implementations, operation 10-427 may include an operation 10-437 for acquiring a first data indicating at least one activity executed by a third party as originally reported by the user as depicted in FIG. 10-4e. For instance, the first data acquisition module 10-201 of the computing device 10-10 acquiring a first data 10-60 indicating at least one activity executed by a third party 10-50 (e.g., another user, a nonuser, or a nonhuman living organism such as a pet or livestock) as originally reported by the user 10-20*.

Various types of activities executed by the third party 10-50 may be indicated by the first data 10-60 acquired through operation 10-437. For example, in some implementations, operation 10-437 may further include an operation 10-438 for acquiring a first data indicating at least a consumption of an item by the third party as originally reported by the user as depicted in FIG. 10-4e. For instance, the first data acquisition module 10-201 of the computing device 10-10 acquiring a first data 10-60 indicating at least a consumption of an item by the third party 10-50* as originally reported by the user 10-20*.

For these implementations, the first data 10-60 acquired through operation 10-438 may indicate the third party 10-50 consuming at least one item from a variety of edible items. For example, in some implementations, operation 10-438 may include an operation 10-439 for acquiring a first data indicating at least a consumption of a food item by the third party as originally reported by the user as depicted in FIG. 10-4e. For instance, the first data acquisition module 10-201 of the computing device 10-10 acquiring a first data 10-60 indicating at least a consumption of a food item (e.g., ice cream) by the third party 10-50 (e.g., pet dog) as originally reported by the user 10-20*.

In alternative implementations, however, operation 10-438 may include an operation 10-440 for acquiring a first data indicating at least a consumption of a medicine by the third party as originally reported by the user as depicted in FIG. 10-4e. For instance, the first data acquisition module 10-201 of the computing device 10-10 acquiring a first data 10-60 indicating at least a consumption of a medicine (e.g., beta blocker) by the third party 10-50 (e.g., a spouse of the user 10-20*) as originally reported by the user 10-20*.

In still other alternative implementations, operation 10-438 may include an operation 10-441 for acquiring a first data indicating at least a consumption of a nutraceutical by the third party as originally reported by the user as depicted in FIG. 10-4e. For instance, the first data acquisition module 10-201 of the computing device 10-10 acquiring a first data 10-60 indicating at least a consumption of a nutraceutical (e.g., Gingko) by the third party (e.g., co-worker) as originally reported by the user 10-20*.

The first data 10-60 acquired through operation 10-437 may indicate other types of activities associated with a third party 10-50 other than a consumption of an item in various alternative implementations. For example, in some implementations, operation 10-437 may include an operation 10-442 for acquiring a first data indicating at least a social or leisure activity executed by the third party as originally reported by the user as depicted in FIG. 10-4e. For instance, the first data acquisition module 10-201 of the computing device 10-10 acquiring a first data 10-60 indicating at least a social or leisure activity (e.g., attending a family function) executed by the third party 10-50 (e.g., another user such as a friend or a family member) as originally reported by the user 10-20*.

In some implementations, operation 10-437 may include an operation 10-443 for acquiring a first data indicating at least a work activity executed by the third party as originally reported by the user as depicted in FIG. 10-4e. For instance, the first data acquisition module 10-201 of the computing device 10-10 acquiring a first data 10-60 indicating at least a work activity (e.g., arriving for work late at 10 AM) executed by the third party 10-50 (e.g., co-worker or a supervisor) as originally reported by the user 10-20*.

In some implementations, operation 10-437 may include an operation 10-444 for acquiring a first data indicating at least an exercise activity executed by the third party as originally reported by the user as depicted in FIG. 10-4e. For instance, the first data acquisition module 10-201 of the computing device 10-10 acquiring a first data 10-60 indicating at least an exercise activity (e.g., going for a walk) executed by the third party (e.g., pet dog) as originally reported by the user 10-20*.

In some implementations, operation 10-437 may include an operation 10-445 for acquiring a first data indicating at least a learning or educational activity executed by the third party as originally reported by the user as depicted in FIG. 10-4e. For instance, the first data acquisition module 10-201 of the computing device 10-10 acquiring a first data 10-60 indicating at least a learning or educational activity (e.g., attending a class) executed by the third party (e.g., an off-spring) as originally reported by the user.

Referring back to FIG. 10-4d, the first data 10-60 acquired through operation 10-427 may indicate other types of objective occurrences in various alternative implementations. For example, in some implementations, operation 10-427 may include an operation 10-446 for acquiring a first data indicating at least a location associated with the user as originally reported by the user as depicted in FIG. 10-4f. For instance, the first data acquisition module 10-201 of the computing device 10-10 acquiring a first data 10-60 indicating at least a location (e.g., geographic location) associated with the user 10-20* as originally reported by the user 10-20*.

In some implementations, operation 10-427 may include an operation 10-447 for acquiring a first data indicating at least a location associated with a third party as originally reported by the user as depicted in FIG. 10-4f. For instance, the first data acquisition module 10-201 of the computing device 10-10 acquiring a first data 10-60 indicating at least a location (e.g., home of the user 10-20*) associated with a third party 10-50 (e.g., in-laws) as originally reported by the user 10-20*.

In some implementations, operation 10-427 may include an operation 10-448 for acquiring a first data indicating at least an external event as originally reported by the user as depicted in FIG. 10-4f. For instance, the first data acquisition module 10-201 of the computing device 10-10 acquiring a first data 10-60 indicating at least an external event (e.g., a sports event or the atmospheric pollution level on a particular day) as originally reported by the user 10-20*.

In some implementations, operation 10-427 may include an operation 10-449 for acquiring a first data indicating one or more physical characteristics of the user as originally reported by the user as depicted in FIG. 10-4f. For instance, the first data acquisition module 10-201 of the computing device 10-10 acquiring a first data 10-60 indicating at least one or more physical characteristics (e.g., blood pressure or skin color) of the user 10-20* as originally reported by the user 10-20*.

In some implementations, operation 10-427 may include an operation 10-450 for acquiring a first data indicating one or more physical characteristics of a third party as originally reported by the user as depicted in FIG. 10-4f. For instance, the first data acquisition module 10-201 of the computing device 10-10 acquiring a first data 10-60 indicating at least one or more physical characteristics (e.g., blood shot eyes) of a third party (e.g., another user such as a friend) as originally reported by the user 10-20*.

Referring back to the data acquisition operation 10-302 of FIG. 10-3, the second data 10-61 indicating at least a second reported event as acquired in the data acquisition operation 10-302 may be acquired through various means and in various different forms. For example, in some implementations, the data acquisition operation 10-302 may include an operation 10-451 for receiving the second data from at least one of a wireless network and a wired network as depicted in FIG. 10-4g. For instance, the network interface reception module 10-216 (which may be the same as the network interface reception module 10-202) of the computing device 10-10 receiving the second data 10-61 (e.g., as originally provided by a sensing device 10-35a) from at least one of a wireless network and a wired network 10-40.

Alternatively, in some implementations, the data acquisition operation 10-302 may include an operation 10-452 for receiving the second data directly from the one or more sensing devices as depicted in FIG. 10-4g. For instance, the sensing device reception module 10-218 of the computing device 10-10 receiving the second data 10-61 directly from the one or more sensing devices 10-35b.

In some implementations, the data acquisition operation 10-302 may include an operation 10-453 for acquiring the second data by prompting the one or more sensing devices to provide the second data as depicted in FIG. 10-4g. For instance, the second data acquisition module 10-215 of the computing device 10-10 acquiring the second data 10-61 by the device prompting module 10-220 prompting (e.g., as indicated by ref 23) the one or more sensing devices 10-35* to provide the second data 10-61.

Various approaches may be employed in operation 10-453 in order to prompt the one or more sensing devices 10-35 to provide the second data 10-61. For example, in some implementations, operation 10-453 may include an operation 10-454 for acquiring the second data by directing or instructing the one or more sensing devices to provide the second data as depicted in FIG. 10-4g. For instance, the second data acquisition module 10-215 of the computing device 10-10 acquiring the second data 10-60 by the sensing device directing/instructing module 10-222 directing or instructing the one or more sensing devices 10-35* to provide the second data 10-61.

In some implementations, operation 10-453 may include an operation 10-455 for acquiring the second data by configuring the one or more sensing devices to provide the second data as depicted in FIG. 10-4g. For instance, the second data acquisition module 10-215 of the computing device 10-10 acquiring the second data 10-60 by the sensing device configuration module 10-224 configuring the one or more sensing devices 10-35* to provide the second data 10-61.

In some implementations, operation 10-453 may include an operation 10-456 for acquiring the second data by requesting the one or more sensing devices to provide the second data as depicted in FIG. 10-4g. For instance, the second data acquisition module 10-215 of the computing device 10-10 acquiring the second data 10-60 by the sensing device requesting module 10-226 requesting (e.g., transmitting a request) the one or more sensing devices 10-35* to provide (e.g., to have access to or to transmit) the second data 10-61.

The second data 10-61 acquired through the data acquisition operation 10-302 of FIG. 10-3 may indicate a wide variety of objective occurrences that may be detected by a sensing device 10-35 including, for example, the objectively observable physical characteristics of the user 10-20*. For example, in various implementations, the data acquisition operation 10-302 may include an operation 10-457 for acquiring the second data including data indicating one or more physical characteristics of the user as originally reported by the one or more sensing devices as depicted in FIG. 10-4h. For instance, the second data acquisition module 10-215 of the computing device 10-10 acquiring the second data 10-61 including data indicating one or more physical characteristics of the user 10-20* as originally reported by the one or more sensing devices 10-35*.

In some implementations, operation 10-457 may include an operation 10-458 for acquiring the second data including data indicating one or more physiological characteristics of the user as originally reported by the one or more sensing devices as depicted in FIG. 10-4h. For instance, the second data acquisition module 10-215 of the computing device 10-10 acquiring the second data 10-61 including data indicating one or more physiological characteristics of the user 10-20* as originally reported by the one or more sensing devices (e.g., physiological sensor devices 10-281).

Various types of physiological characteristics of the user 10-20* may be indicated by the second data 10-61 acquired through operation 10-458 in various alternative implementations. For example, in some implementations, operation 10-458 may include an operation 10-459 for acquiring the second data including heart rate sensor data relating to the user as depicted in FIG. 10-4h. For instance, the second data acquisition module 10-215 of the computing device 10-10 acquiring the second data 10-61 including heart rate sensor data relating to the user 10-20* as at least originally provided by, for example, a heart rate sensor device 10-282.

In some implementations, operation 10-458 may include an operation 10-460 for acquiring the second data including blood pressure sensor data relating to the user as depicted in FIG. 10-4h. For instance, the second data acquisition module 10-215 of the computing device 10-10 acquiring the second data 10-61 including blood pressure sensor data relating to the user 10-20* as at least originally provided by, for example, a blood pressure sensor device 10-283.

In some implementations, operation 10-458 may include an operation 10-461 for acquiring the second data including glucose sensor data relating to the user as depicted in FIG. 10-4h. For instance, the second data acquisition module 10-215 of the computing device 10-10 acquiring the second data 10-61 including glucose sensor data relating to the user 10-20* as at least originally provided by, for example, a blood glucose sensor device 10-284 (e.g., glucometer).

In some implementations, operation 10-458 may include an operation 10-462 for acquiring the second data including blood cell-sorting sensor data relating to the user as depicted in FIG. 10-4h. For instance, the second data acquisition module 10-215 of the computing device 10-10 acquiring the second data 10-61 including blood cell-sorting sensor data relating to the user 10-20* as provided by, for example, a blood cell-sorting sensor device 10-322.

In some implementations, operation 10-458 may include an operation 10-463 for acquiring the second data including sensor data relating to blood oxygen or blood volume changes of a brain of the user as depicted in FIG. 10-4h. For instance, the second data acquisition module 10-215 of the computing device 10-10 acquiring the second data 10-61 including sensor data relating to blood oxygen or blood volume changes of a brain of the user 10-20* as at least originally provided by, for example, an fMRI device 10-285 and/or an fNIR device 10-286.

In some implementations, operation 10-458 may include an operation 10-464 for acquiring the second data including blood alcohol sensor data relating to the user as depicted in FIG. 10-4h. For instance, the second data acquisition module 10-215 of the computing device 10-10 acquiring the second data 10-61 including blood alcohol sensor data relating to the user 10-20* as at least originally provided by, for example, a blood alcohol sensor device 10-287.

In some implementations, operation 10-458 may include an operation 10-465 for acquiring the second data including temperature sensor data relating to the user as depicted in FIG. 10-4h. For instance, the second data acquisition module 10-215 of the computing device 10-10 acquiring the second data 10-61 including temperature sensor data relating to the user 10-20* as at least originally provided by, for example, temperature sensor device 10-288.

In some implementations, operation 10-458 may include an operation 10-466 for acquiring the second data including respiration sensor data relating to the user as depicted in FIG. 10-4h. For instance, the second data acquisition module 10-215 of the computing device 10-10 acquiring the second data 10-61 including respiration sensor data relating to the user 10-20* as at least originally provided by, for example, a respiration sensor device 10-289.

In various implementations, operation 10-457 of FIG. 10-4h for acquiring the data indicating one or more physical characteristics of the user 10-20* may include an operation 10-467 for acquiring the second data including imaging system data relating to the user as depicted in FIG. 10-4h. For instance, the second data acquisition module 10-215 of the computing device 10-10 acquiring the second data 10-61 including imaging system data relating to the user 10-20* as at least originally provided by, for example, one or more image system devices 10-290 (e.g., a digital or video camera, an x-ray machine, an ultrasound device, an fMRI device, an fNIR device, and so forth).

Referring back to the data acquisition operation 10-302 of FIG. 10-3, in various implementations, the second data 10-61 acquired through the data acquisition operation 10-302 may indicate one or more activities executed by the user 10-20* as originally reported by one or more sensing devices 10-35*. For example, in some implementations, the data acquisition operation 10-302 may include an operation 10-468 for acquiring the second data including data indicating one or more activities of the user as depicted in FIG. 10-4i. For instance, the second data acquisition module 10-215 of the computing device 10-10 acquiring the second data 10-61 including data indicating one or more activities of the user 10-20* as at least originally provided by, for example, one or more user activity sensing devices 10-291.

The data indicating the one or more activities of the user 10-20* acquired through operation 10-468 may be acquired from any one or more of a variety of different sensing devices 10-35* capable of sensing the activities of the user 10-20*. For example, in some implementations, operation 10-468 may include an operation 10-469 for acquiring the second data including pedometer data relating to the user as depicted in FIG. 10-4i. For instance, the second data acquisition module 10-215 of the computing device 10-10 acquiring the second data 10-61 including pedometer data relating to the user 10-20* as at least originally provided by, for example, a pedometer 10-292.

In some implementations, operation 10-468 may include an operation 10-470 for acquiring the second data including accelerometer device data relating to the user as depicted in FIG. 10-4i. For instance, the second data acquisition module 10-215 of the computing device 10-10 acquiring the second data 10-61 including accelerometer device data relating to the user 10-20* as at least originally provided by, for example, an accelerometer 10-293.

In some implementations, operation 10-468 may include an operation 10-471 for acquiring the second data including image capturing device data relating to the user as depicted in FIG. 10-4i. For instance, the second data acquisition module 10-215 of the computing device 10-10 acquiring the second data 10-61 including image capturing device data relating to the user 10-20* as at least originally provided by, for example, an image capturing device 10-294 (e.g. digital or video camera to capture user movements).

In some implementations, operation 10-468 may include an operation 10-472 for acquiring the second data including toilet monitoring device data relating to the user as depicted in FIG. 10-4i. For instance, the second data acquisition module 10-215 of the computing device 10-10 acquiring the second data 10-61 including toilet monitoring device data relating to usage of a toilet by the user 10-20* as at least originally provided by, for example, a toilet monitoring device 10-295.

In some implementations, operation 10-468 may include an operation 10-473 for acquiring the second data including exercising machine sensor data relating to the user as depicted in FIG. 10-4i. For instance, the second data acquisition module 10-215 of the computing device 10-10 acquiring the second data 10-61 including exercising machine sensor data relating to exercise machine activities of the user 10-20* as at least originally provided by, for example, an exercise machine sensor device 10-296.

Various other types of events related to the user 10-20*, as originally reported by one or more sensing devices 10-35*, may be indicated by the second data 10-61 acquired in the data acquisition operation 10-302. For example, in some implementations, the data acquisition operation 10-302 may include an operation 10-474 for acquiring the second data including global positioning system (GPS) data indicating at least one location of the user as depicted in FIG. 10-4i. For instance, the second data acquisition module 10-215 of the computing device 10-10 acquiring the second data 10-61 including global positioning system (GPS) data indicating at least one location of the user 10-20* as at least originally provided by, for example, a GPS 10-297.

In some implementations, the data acquisition operation 10-302 may include an operation 10-475 for acquiring the second data including temperature sensor data indicating at least one environmental temperature associated with a location of the user as depicted in FIG. 10-4i. For instance, the second data acquisition module 10-215 of the computing device 10-10 acquiring the second data 10-61 including temperature sensor data indicating at least one environmental temperature associated with a location of the user 10-20* as at least originally provided by, for example, an environmental temperature sensor device 10-298.

In some implementations, the data acquisition operation 10-302 may include an operation 10-476 for acquiring the second data including humidity sensor data indicating at least one environmental humidity level associated with a location of the user as depicted in FIG. 10-4i. For instance, the second data acquisition module 10-215 of the computing device 10-10 acquiring the second data 10-61 including humidity sensor data indicating at least one environmental humidity level associated with a location of the user 10-20* as at least originally provided by, for example, an environmental humidity sensor device 10-299.

In some implementations, the data acquisition operation 10-302 may include an operation 10-477 for acquiring the second data including air pollution sensor data indicating at least one air pollution level associated with a location of the user as depicted in FIG. 10-4i. For instance, the second data acquisition module 10-215 of the computing device 10-10 acquiring the second data 10-61 including air pollution sensor data indicating at least one air pollution level (e.g., ozone level, carbon dioxide level, particulate level, pollen level, and so forth) associated with a location of the user 10-20* as at least originally provided by, for example, an environmental air pollution sensor device 10-320.

In various implementations, the second data 10-61 acquired through the data acquisition operation 10-302 of FIG. 10-3 may indicate events originally reported by one or more sensing devices 10-35* that relates to a third party 10-50 (e.g., another user, a nonuser, or a nonhuman living organism such as a pet or livestock). For example, in some implementations, the data acquisition operation 10-302 may include an operation 10-478 for acquiring the second data including data indicating one or more physical characteristics of a third party as originally reported by the one or more sensing devices as depicted in FIG. 10-4j. For instance, the second data acquisition module 10-215 of the computing device 10-10 acquiring the second data 10-61 including one or more physical characteristics of a third party 10-50 as originally reported by one or more sensing devices 10-35a.

In various implementations, operation 10-478 may further include an operation 10-479 for acquiring the second data including data indicating one or more physiological characteristics of the third party as originally reported by the one or more sensing devices as depicted in FIG. 10-4j. For instance, the second data acquisition module 10-215 of the computing device 10-10 acquiring the second data 10-61 including data indicating one or more physiological characteristics of the third party 10-50 as originally reported by the one or more sensing devices 10-35a (e.g., a physiological sensor device 10-281).

In various implementations, the second data 10-61 acquired through operation 10-479 may indicate at least one of a variety of physiological characteristics that may be associated with the third party 10-50*. For example, in some implementations, operation 10-479 may include an operation 10-480 for acquiring the second data including heart rate sensor data relating to the third party as depicted in FIG. 10-4j. For instance, the second data acquisition module 10-215 of the computing device 10-10 acquiring the second data 10-61 including heart rate sensor data relating to the third party 10-50 as at least originally provided by, for example, a heart rate sensor device 10-282.

In some implementations, operation 10-479 may include an operation 10-481 for acquiring the second data including blood pressure sensor data relating to the third party as depicted in FIG. 10-4j. For instance, the second data acquisition module 10-215 of the computing device 10-10 acquiring the second data 10-61 including blood pressure sensor data relating to the third party 10-50 as at least originally provided by, for example, a blood pressure sensor device 10-283.

In some implementations, operation 10-479 may include an operation 10-482 for acquiring the second data including glucose sensor data relating to the third party as depicted in FIG. 10-4j. For instance, the second data acquisition module 10-215 of the computing device 10-10 acquiring the second data 10-61 including glucose sensor data relating to the third party 10-50 as at least originally provided by, for example, a blood glucose sensor device 10-284.

In some implementations, operation 10-479 may include an operation 10-483 for acquiring the second data including blood cell-sorting sensor data relating to the third party as depicted in FIG. 10-4j. For instance, the second data acquisition module 10-215 of the computing device 10-10 acquiring the second data 10-61 including blood cell-sorting sensor data relating to the third party 10-50 as at least originally provided by, for example, a blood cell-sorting sensor device 10-322.

In some implementations, operation 10-479 may include an operation 10-484 for acquiring the second data including sensor data relating to blood oxygen or blood volume changes of a brain of the third party as depicted in FIG. 10-4j. For instance, the second data acquisition module 10-215 of the computing device 10-10 acquiring the second data 10-61 including sensor data relating to blood oxygen or blood volume changes of a brain of the third party 10-50 as at least originally provided by, for example, an fMRI device 10-285 and/or an fNIR device 10-286.

In some implementations, operation 10-479 may include an operation 10-485 for acquiring the second data including blood alcohol sensor data relating to the third party as depicted in FIG. 10-4j. For instance, the second data acquisition module 10-215 of the computing device 10-10 acquiring the second data 10-61 including blood alcohol sensor data relating to the third party 10-50 as at least originally provided by, for example, a blood alcohol sensor device 10-287.

In some implementations, operation 10-479 may include an operation 10-486 for acquiring the second data including temperature sensor data relating to the third party as depicted in FIG. 10-4j. For instance, the second data acquisition module 10-215 of the computing device 10-10 acquiring the second data 10-61 including temperature sensor data relating to the third party 10-50 as at least originally provided by, for example, temperature sensor device 10-288.

In some implementations, operation 10-479 may include an operation 10-487 for acquiring the second data including respiration sensor data relating to the third party as depicted in FIG. 10-4j. For instance, the second data acquisition module 10-215 of the computing device 10-10 acquiring the second data 10-61 including respiration sensor data relating to the third party 10-50 as at least originally provided by, for example, a respiration sensor device 10-289.

In various implementations, operation 10-478 of FIG. 10-4j for acquiring the data indicating one or more physical characteristics of the third party 10-50 may include an operation 10-488 for acquiring the second data including imaging system data relating to the third party as depicted in FIG. 10-4j. For instance, the second data acquisition module 10-215 of the computing device 10-10 acquiring the second data 10-61 including imaging system data relating to the third party 10-50 as at least originally provided by, for example, one or more image system devices 10-290 (e.g., a digital or video camera, an x-ray machine, an ultrasound device, an fMRI device, an fNIR device, and so forth).

Referring back to the data acquisition operation 10-302 of FIG. 10-3, in various implementations the second data 10-61 acquired through the data acquisition operation 10-302 may indicate one or more activities executed by a third party 10-50 as originally reported by one or more sensing devices 10-35a. For example, in some implementations, the data acquisition operation 10-302 may include an operation 10-489 for acquiring the second data including data indicating one or more activities of a third party as depicted in FIG. 10-4k. For instance, the second data acquisition module 10-215 of the computing device 10-10 acquiring the second data 10-61 including data indicating one or more activities of a third party 10-50 as at least originally provided by, for example, one or more user activity sensing devices 10-291.

The data indicating the one or more activities of the third party 10-50 acquired through operation 10-489 may be acquired from any one or more of a variety of different sensing devices 10-35* capable of sensing the activities of the user 10-20*. For example, in some implementations, operation 10-489 may include an operation 10-490 for acquiring the second data including pedometer data relating to the third party as depicted in FIG. 10-4k. For instance, the second data acquisition module 10-215 of the computing device 10-10 acquiring the second data 10-61 including pedometer data relating to the third party 10-50 as at least originally provided by, for example, a pedometer 10-292.

In some implementations, operation 10-489 may include an operation 10-491 for acquiring the second data including accelerometer device data relating to the third party as depicted in FIG. 10-4k. For instance, the second data acquisition module 10-215 of the computing device 10-10 acquiring the second data 10-61 including accelerometer device data relating to the third party 10-50 as at least originally provided by, for example, an accelerometer 10-293.

In some implementations, operation 10-489 may include an operation 10-492 for acquiring the second data including image capturing device data relating to the third party as depicted in FIG. 10-4k. For instance, the second data acquisition module 10-215 of the computing device 10-10 acquiring the second data 10-61 including image capturing device data relating to the third party 10-50 as at least originally provided by, for example, an image capturing device 10-294 (e.g. digital or video camera to capture user movements).

In some implementations, operation 10-489 may include an operation 10-493 for acquiring the second data including toilet monitoring sensor data relating to the third party as depicted in FIG. 10-4k. For instance, the second data acquisition module 10-215 of the computing device 10-10 acquiring the second data 10-61 including toilet monitoring sensor data relating to usage of a toilet by the third party 10-50 as at least originally provided by, for example, a toilet monitoring device 10-295.

In some implementations, operation 10-489 may include an operation 10-494 for acquiring the second data including exercising machine sensor data relating to the third party as depicted in FIG. 10-4k. For instance, the second data acquisition module 10-215 of the computing device 10-10 acquiring the second data 10-61 including exercising machine sensor data relating to exercise machine activities of the third party 10-50 as at least originally provided by, for example, an exercise machine sensor device 10-296.

Various other types of events related to a third party 10-50, as originally reported by one or more sensing devices 10-35*, may be indicated by the second data 10-61 acquired in the data acquisition operation 10-302. For example, in some implementations, the data acquisition operation 10-302 may include an operation 10-495 for acquiring the second data including global positioning system (GPS) data indicating at least one location of a third party as depicted in FIG. 10-4k. For instance, the second data acquisition module 10-215 of the computing device 10-10 acquiring the second data 10-61 including global positioning system (GPS) data indicating at least one location of a third party 10-50 as at least originally provided by, for example, a GPS 10-297.

In some implementations, the data acquisition operation 10-302 may include an operation 10-496 for acquiring the second data including temperature sensor data indicating at least one environmental temperature associated with a location of a third party as depicted in FIG. 10-4k. For instance, the second data acquisition module 10-215 of the computing device 10-10 acquiring the second data 10-61 including temperature sensor data indicating at least one environmental temperature associated with a location of a third party 10-50 as at least originally provided by, for example, an environmental temperature sensor device 10-298.

In some implementations, the data acquisition operation 10-302 may include an operation 10-497 for acquiring the second data including humidity sensor data indicating at least one environmental humidity level associated with a location of a third party as depicted in FIG. 10-4k. For instance, the second data acquisition module 10-215 of the computing device 10-10 acquiring the second data 10-61 including humidity sensor data indicating at least one environmental humidity level associated with a location of a third party 10-50 as at least originally provided by, for example, an environmental humidity sensor device 10-299.

In some implementations, the data acquisition operation 10-302 may include an operation 10-498 for acquiring the second data including air pollution sensor data indicating at least one air pollution level associated with a location of the third party as depicted in FIG. 10-4k. For instance, the second data acquisition module 10-215 of the computing device 10-10 acquiring the second data 10-61 including air pollution sensor data indicating at least one air pollution level (e.g., ozone level, carbon dioxide level, particulate level, pollen level, and so forth) associated with a location of a third party 10-50 as at least originally provided by, for example, an environmental air pollution sensor device 10-320.

In various alternative implementations, the second data 10-61 acquired through the data acquisition operation 10-302 of FIG. 10-3 may indicate at least a second reported event that may be related to a device or an environmental characteristic. For example, in some implementations, the data acquisition operation 10-302 may include an operation 10-499 for acquiring the second data including device performance sensor data indicating at least one performance indication of a device as depicted in FIG. 10-4l. For instance, the second data acquisition module 10-215 of the computing device 10-10 acquiring the second data 10-61 including device performance sensor data indicating at least one performance indication (e.g., indication of operational performance) of a device (e.g., household appliance, automobile, communication device such as a mobile phone, medical device, and so forth).

In some alternative implementations, the data acquisition operation 10-302 may include an operation 10-500 for acquiring the second data including device characteristic sensor data indicating at least one characteristic of a device as depicted in FIG. 10-4l. For instance, the second data acquisition module 10-215 of the computing device 10-10 acquiring the second data 10-61 including device characteristic sensor data indicating at least one characteristic (e.g., air pressure) of a device (e.g., tires).

In some alternative implementations, the data acquisition operation 10-302 may include an operation 10-501 for acquiring the second data including environmental characteristic sensor data indicating at least one environmental characteristic as depicted in FIG. 10-4l. For instance, the second data acquisition module 10-215 of the computing device 10-10 acquiring the second data 10-61 including environmental characteristic sensor data indicating at least one environmental characteristic. Such an environmental characteristic sensor data may indicate, for example, air pollution levels or water purity levels of a local drinking water supply.

In some implementations, the data acquisition operation 10-302 of FIG. 10-3 may include an operation 10-502 for acquiring a third data indicating a third reported event as originally reported by a third party as depicted in FIG. 10-4l. For instance, the events data acquisition module 10-102 of the computing device 10-10 acquiring a third data 10-62 indicating a third reported event as originally reported by a third party 10-50. As an illustration, suppose a user 10-20* provides a first data 10-60 that indicates that the user 10-20* felt nauseous in the morning (e.g., subjective user state) and a sensing device 10-35*, such as a blood alcohol sensor device 10-287, provides a second data 10-61 indicating that the user 10-20* had a slightly elevated blood alcohol level, then a third party 10-50 (e.g., spouse) may provide a third data 10-62 that indicates that the third party 10-50 observed the user 10-20* staying up late the previous evening. This may ultimately result in a hypothesis being developed that indicates that there is a link between moderate alcohol consumption and staying up late with feeling nauseous.

In alternative implementations, the data acquisition operation 10-302 may include an operation 10-503 for acquiring a third data indicating a third reported event as originally reported by another one or more sensing devices as depicted in FIG. 10-4l. For instance, the events data acquisition module 10-102 of the computing device 10-10 acquiring a third data (e.g., fourth data 10-63 in FIG. 10-1a and 10-1b) indicating a third reported event as originally reported by another one or more sensing devices 10-35*.

In still other alternative implementations, the data acquisition operation 10-302 may include an operation 10-504 for acquiring a third data indicating a third reported event as originally reported by a third party and a fourth data indicating a fourth reported event as originally reported by another one or more sensing devices as depicted in FIG. 10-4m. For instance, the events data acquisition module 10-102 of the computing device 10-10 acquiring a third data 10-62 indicating a third reported event as originally reported by a third party 10-50 and a fourth data 10-63 indicating a fourth reported event as originally reported by another one or more sensing devices 10-35.

In order to facilitate the development of a hypothesis, the data acquisition operation 10-302 of FIG. 10-3 may involve the acquisition of time or spatial data related to the first reported event and the second reported event. For example, in various implementations, the data acquisition operation 10-302 may include an operation 10-505 for acquiring a first time element associated with the at least one reported event and a second time element associated with the at least second reported event as depicted in FIG. 10-4m. For instance, the time element acquisition module 10-228 of the computing device 10-10 acquiring a first time element associated with the at least one reported event (e.g., angry exchange with boss) and a second time element associated with the at least second reported event (e.g., elevated blood pressure).

In some implementations, operation 10-505 may comprise an operation 10-506 for acquiring a first time stamp associated with the at least one reported event and a second time stamp associated with the at least second reported event as depicted in FIG. 10-4m. For instance, the time stamp acquisition module 10-230 of the computing device 10-10 acquiring (e.g., receiving or self-generating) a first time stamp (e.g., 9 PM) associated with the at least one reported event (e.g., upset stomach) and a second time stamp (e.g., 7 PM) associated with the at least second reported event (e.g., visiting a particular restaurant as indicated by data provided by a GPS 10-297 or an accelerometer 10-293).

In some implementations, operation 10-505 may comprise an operation 10-507 for acquiring an indication of a first time interval associated with the at least one reported event and an indication of second time interval associated with the at least second reported event as depicted in FIG. 10-4m. For instance, the time interval indication acquisition module 10-232 of the computing device 10-10 acquiring (e.g., receiving or self-generating) an indication of a first time interval (e.g., 2 PM to 4 PM) associated with the at least one reported event (e.g., neighbor's dog being let out) and an indication of a second time interval (e.g., 3 PM to 4:40 PM) associated with the at least second reported event (e.g., user's dog staying near fence line as indicated by a GPS 10-297 coupled to the user's dog).

In some implementations, the data acquisition operation 10-302 may comprise an operation 10-508 for acquiring an indication of a first spatial location associated with the at least one reported event and an indication of a second spatial location associated with the at least second reported event as depicted in FIG. 10-4m. For instance, the spatial location indication acquisition module 10-234 of the computing device 10-10 acquiring (e.g., receiving or self-generating) an indication of a first spatial location (e.g., place of employment) associated with the at least one reported event (e.g., boss is out of office) and an indication of a second spatial location (e.g., place of employment) associated with the at least second reported event (e.g., reduced blood pressure).

Referring back to FIG. 10-3, the hypothesis development operation 10-304 may be executed in a number of different ways in various alternative implementations. For example, in some implementations, the hypothesis development operation 10-304 may include an operation 10-509 for developing a hypothesis by creating the hypothesis based, at least in part, on the at least one reported event and the at least second reported event as depicted in FIG. 10-5a. For instance, the hypothesis development module 10-104 of the computing device 10-10 developing a hypothesis based on the hypothesis creation module 10-236 creating the hypothesis based, at least in part, on the at least one reported event and the at least second reported event.

In some instances, operation 10-509 may include an operation 10-510 for creating the hypothesis based, at least in part, on the at least one reported event, the at least second reported event, and historical data as depicted in FIG. 10-5a. For instance, the hypothesis creation module 10-236 of the computing device 10-10 creating the hypothesis based, at least in part, on the at least one reported event, the at least second reported event, and historical data 10-81 (e.g., past reported events or historical events pattern).

In some implementations, operation 10-510 may further include an operation 10-511 for creating the hypothesis based, at least in part, on the at least one reported event, the at least second reported event, and historical data that is particular to the user or a sub-group of a general population that the user belongs to as depicted in FIG. 10-5a. For instance, the hypothesis creation module 10-236 of the computing device 10-10 creating the hypothesis based, at least in part, on the at least one reported event, the at least second reported event, and historical data 10-81 that is particular to the user 10-20* or a sub-group of a general population that the user belongs to. Such a historical data 10-81 may include historical events pattern that may be associated with the user 10-20* or the sub-group of the general population.

In various implementations, the hypothesis created through operation 10-509 may be implemented by determining an events pattern. For example, in some instances, operation 10-509 may include an operation 10-512 for creating the hypothesis by determining an events pattern based, at least in part, on occurrence of the at least one reported event and occurrence of the at least second reported event as depicted in FIG. 10-5a. For instance, the hypothesis creation module 10-236 of the computing device 10-10 creating the hypothesis based on the events pattern determination module 10-238 determining an events pattern based, at least in part, on occurrence (e.g., time or spatial occurrence) of the at least one reported event and occurrence (e.g., time or spatial occurrence) of the at least second reported event.

In some implementations, operation 10-512 may include an operation 10-513 for creating the hypothesis by determining a sequential events pattern based at least in part on time occurrence of the at least one reported event and time occurrence of the at least second reported event as depicted in FIG. 10-5a. For instance, the hypothesis creation module 10-236 of the computing device 10-10 creating the hypothesis based on the sequential events pattern determination module 10-240 determining a sequential events pattern based at least in part on time occurrence of the at least one reported event and time occurrence of the at least second reported event.

In some implementations, operation 10-512 may include an operation 10-514 for creating the hypothesis by determining a spatial events pattern based at least in part on spatial occurrence of the at least one reported event and spatial occurrence of the at least second reported event as depicted in FIG. 10-5a. For instance, the hypothesis creation module 10-236 of the computing device 10-10 creating the hypothesis based on the spatial events pattern determination module 10-242 determining a spatial events pattern based at least in part on spatial occurrence of the at least one reported event and spatial occurrence of the at least second reported event.

In various implementations, the hypothesis development operation 10-302 of FIG. 10-3 may involve the refinement of an already existing hypothesis. For example, in some implementations, the hypothesis development operation 10-302 may include an operation 10-515 for developing a hypothesis by refining an existing hypothesis based, at least in part, on the at least one reported event and the at least second reported event as depicted in FIG. 10-5b. For instance, the hypothesis development module 10-104 of the computing device 10-10 developing a hypothesis by the existing hypothesis refinement module 10-244 refining (e.g., further defining or developing) an existing hypothesis 10-80 based, at least in part, on the at least one reported event and the at least second reported event.

Various approaches may be employed in order to refine an existing hypothesis 10-80 in operation 10-515. For example, in some implementations, operation 10-515 may include an operation 10-516 for refining the existing hypothesis by at least determining an events pattern based, at least in part, on occurrence of the at least one reported event and occurrence of the at least second reported event as depicted in FIG. 10-5b. For instance, the existing hypothesis refinement module 10-244 of the computing device 10-10 refining the existing hypothesis 10-80 by the events pattern determination module 10-246 at least determining an events pattern based, at least in part, on occurrence of the at least one reported event and occurrence of the at least second reported event.

Operation 10-516, in turn, may further comprise an operation 10-517 for refining the existing hypothesis by at least determining a sequential events pattern based, at least in part, on time occurrence of the at least one reported event and time occurrence of the at least second reported event as depicted in FIG. 10-5b. For instance, the existing hypothesis refinement module 10-244 of the computing device 10-10 refining the existing hypothesis 10-80 by the sequential events pattern determination module 10-248 at least determining a sequential events pattern based, at least in part, on time occurrence of the at least one reported event and time occurrence of the at least second reported event.

In some alternative implementations, operation 10-516 may include an operation 10-518 for refining the existing hypothesis by at least determining a spatial events pattern based, at least in part, on spatial occurrence of the at least one reported event and spatial occurrence of the at least second reported event as depicted in FIG. 10-5b. For instance, the existing hypothesis refinement module 10-244 of the computing device 10-10 refining the existing hypothesis 10-80 by the spatial events pattern determination module 10-250 at least determining a sequential events pattern based, at least in part, on spatial occurrence of the at least one reported event and spatial occurrence of the at least second reported event.

In some implementations, operation 10-516 may include an operation 10-519 for refining the existing hypothesis by determining whether the determined events pattern supports the existing hypothesis as depicted in FIG. 10-5b. For instance, the existing hypothesis refinement module 10-244 of the computing device 10-10 refining the existing hypothesis 10-80 by the support determination module 10-252 determining whether the determined events pattern supports (or contradicts) the existing hypothesis 10-80 (e.g., the determined events pattern at least generally matches or is at least generally in-line with the existing hypothesis 10-80).

In various implementations, operation 10-519, in turn, may include an operation 10-520 for comparing the determined events pattern with an events pattern associated with the existing hypothesis to determine whether the determined events pattern supports the existing hypothesis as depicted in FIG. 10-5b. For instance, the comparison module 10-254 of the computing device 10-10 comparing he determined events pattern with an events pattern associated with the existing hypothesis 10-80 to determine whether the determined events pattern supports (or contradicts) the existing hypothesis 10-80.

In some implementations, operation 10-520 may further include an operation 10-521 for determining soundness of the existing hypothesis based on the comparison as depicted in FIG. 10-5b. For instance, the soundness determination module 10-256 of the computing device 10-10 determining soundness of the existing hypothesis 10-80 (e.g., whether the existing hypothesis 10-80 is a weak or a strong hypothesis) based on the comparison made, for example, by the comparison module 10-254. Note that the determination of “soundness” in operation 10-521 appears to be relatively close to the determination of “support” in operation 10-520. However, these operations may be distinct as it may be possible to have, for example, a determined events that does not support (e.g., contradicts) the existing hypothesis 10-80 (as determined in operation 10-520) while still determining that the existing hypothesis 10-80 is sound when there is, for example, strong historical data (e.g., a number of past events pattern) that supports the existing hypothesis 10-80. In such a scenario, the determination of a contradictory events pattern (e.g., operation 10-520) may result in a weaker hypothesis.

In some implementations, operation 10-520 may further include an operation 10-522 for modifying the existing hypothesis based on the comparison as depicted in FIG. 10-5b. For instance, the modification module 10-258 of the computing device 10-10 modifying the existing hypothesis 10-80 based on the comparison made, for example, by the comparison module 10-254. As an illustration, suppose an existing hypothesis 10-80 links the consumption of ice cream and coffee with increased toilet use. Suppose further that the events pattern determined by the events pattern determination module 10-246 (e.g., determined based on the first reported event and the second reported event) indicates that increased toilet use (e.g., as reported by the toilet monitoring device 10-295) occurred after only consuming ice cream (e.g., as reported by the user 10-20*). Then the modification module 10-258 may modify the existing hypothesis 10-80 to link increased toilet use with only the consumption of ice cream.

In various implementations, the hypothesis to be developed in the hypothesis development operation 10-304 of FIG. 10-3 may be related to any one or more of a variety of different entities. For example, in some implementations, the hypothesis development operation 10-304 may include an operation 10-523 for developing a hypothesis that relates to the user as depicted in FIG. 10-5c. For instance, the hypothesis development module 10-104 of the computing device 10-10 developing a hypothesis (e.g., creating a new hypothesis or refining an existing hypothesis 10-80) that relates to the user 10-20*.

In some alternative implementations, the hypothesis development operation 10-304 may include an operation 10-524 for developing a hypothesis that relates to a third party as depicted in FIG. 10-5c. For instance, the hypothesis development module 10-104 of the computing device 10-10 developing a hypothesis (e.g., creating a new hypothesis or refining an existing hypothesis 10-80) that relates to a third party 10-50 (e.g., another user, a nonuser, a pet, a livestock, and so forth).

In some implementations, operation 10-524 may include an operation 10-525 for developing a hypothesis that relates to a person as depicted in FIG. 10-5c. For instance, the hypothesis development module 10-104 of the computing device 10-10 developing a hypothesis (e.g., creating a new hypothesis or refining an existing hypothesis 10-80) that relates to a person (e.g., another user or nonuser).

In some implementations, operation 10-524 may include an operation 10-526 for developing a hypothesis that relates to a non-human living organism as depicted in FIG. 10-5c. For instance, the hypothesis development module 10-104 of the computing device 10-10 developing a hypothesis (e.g., creating a new hypothesis or refining an existing hypothesis 10-80) that relates to a non-human living organism (e.g., a pet such as a dog, a cat, or a bird, a livestock, or other types of living creatures).

In various implementations, the hypothesis development operation 10-304 may include an operation 10-527 for developing a hypothesis that relates to a device as depicted in FIG. 10-5c. For instance, the hypothesis development module 10-104 of the computing device 10-10 developing a hypothesis (e.g., creating a new hypothesis or refining an existing hypothesis 10-80) that relates to a device 10-55 (e.g., an automobile or a part of the automobile, a household appliance or a part of the household appliance, a mobile communication device, a computing device, and so forth).

In some implementations, the hypothesis development operation 10-304 may include an operation 10-528 for developing a hypothesis that relates to an environmental characteristic as depicted in FIG. 10-5c. For instance, the hypothesis development module 10-104 of the computing device 10-10 developing a hypothesis (e.g., creating a new hypothesis or refining an existing hypothesis 10-80) that relates to an environmental characteristic (e.g., weather, water quality, air quality, and so forth).

Referring now to FIG. 10-6 illustrating another operational flow 10-600 in accordance with various embodiments. In some embodiments, operational flow 10-600 may be particularly suited to be performed by the computing device 10-10, which may be a network server or a standalone computing device. Operational flow 10-600 includes operations that mirror the operations included in the operational flow 10-300 of FIG. 10-3. For example, operational flow 10-600 may include a data acquisition operation 10-602 and a hypothesis development operation 10-604 that corresponds to and mirror the data acquisition operation 10-302 and the hypothesis development operation 10-304, respectively, of FIG. 10-3.

In addition, and unlike operational flow 10-300, operational flow 10-600 may further include an action execution operation 10-606 for executing one or more actions in response at least in part to the developing (e.g., developing of a hypothesis performed in the hypothesis development operation 10-604 of operational flow 10-600). For instance, the action execution module 10-106 of the computing device 10-10 executing one or more actions in response at least in part to the developing of the hypothesis (e.g., developing of the hypothesis as in the hypothesis development operation 10-604).

Various types of actions may be executed in the action execution operation 10-606 in various alternative implementations. For example, in some implementations, the action execution operation 10-606 may include an operation 10-730 for presenting one or more advisories relating to the hypothesis as depicted in FIG. 10-7a. For instance, the advisory presentation module 10-260 of the computing device 10-10 presenting one or more advisories relating to the hypothesis.

The presentation of the one or more advisories in operation 10-730 may be performed in various ways. For example, in some implementations, operation 10-730 may include an operation 10-731 for indicating the one or more advisories related to the hypothesis via a user interface as depicted in FIG. 10-7a. For instance, the advisory indication module 10-262 of the computing device 10-10 indicating the one or more advisories related to the hypothesis via a user interface 10-122 (e.g., a display monitor, a touchscreen, a speaker system, and so forth).

In same or different implementations, operation 10-730 may include an operation 10-732 for transmitting the one or more advisories related to the hypothesis via at least one of a wireless network or a wired network as depicted in FIG. 10-7a. For instance, the advisory transmission module 10-264 of the computing device 10-10 transmitting (e.g., via a network interface 10-120) the one or more advisories related to the hypothesis via at least one of a wireless network or a wired network 10-40.

In some implementations, operation 10-732 may further include an operation 10-733 for transmitting the one or more advisories related to the hypothesis to the user as depicted in FIG. 10-7a. For instance, the advisory transmission module 10-264 of the computing device 10-10 transmitting (e.g., via a network interface 10-120 and to mobile device 10-30) the one or more advisories related to the hypothesis to the user 10-20a.

In the same or different implementations, operation 10-732 may include an operation 10-734 for transmitting the one or more advisories related to the hypothesis to one or more third parties as depicted in FIG. 10-7a. For instance, the advisory transmission module 10-264 of the computing device 10-10 transmitting (e.g., via a network interface 10-120) the one or more advisories related to the hypothesis to one or more third parties 10-50 (e.g., other users or nonusers, content providers, advertisers, network service providers, and so forth).

In operation 10-730 of FIG. 10-7a, various types of advisories may be presented in various alternative implementations. For example, in some implementations, operation 10-730 may include an operation 10-735 for presenting at least one form of the hypothesis as depicted in FIG. 10-7b. For instance, the hypothesis presentation module 10-266 of the computing device 10-10 presenting (e.g., transmitting via a wireless and/or wired network 10-40 or indicated via a user interface 10-122) at least one form (e.g., audio, graphical, or text form) of the hypothesis.

In various instances, operation 10-735 may further comprise an operation 10-736 for presenting an indication of a relationship between at least a first event type and at least a second event type as referenced by the hypothesis as depicted in FIG. 10-7b. For instance, the event types relationship presentation module 10-268 of the computing device 10-10 presenting an indication of a relationship between at least a first event type (e.g., a type of event such as a subjective user state, a subjective observation, or an objective occurrence) and at least a second event type (e.g., a type of event such as an objective occurrence) as referenced by the hypothesis. For example, a hypothesis may hypothesize that a person may feel tense (e.g., subjective user state) or appear to be tense (e.g., subjective observation by another person) whenever the user blood pressure is high (e.g., objective occurrence). Note that a hypothesis does not need to indicate a cause/effect relationship, but instead, may merely indicate a linkage between different event types.

In some implementations, operation 10-736 may include an operation 10-737 for presenting an indication of soundness of the hypothesis as depicted in FIG. 10-7b. For instance, the hypothesis soundness presentation module 10-270 of the computing device 10-10 presenting an indication of soundness (e.g., strength or weakness) of the hypothesis. As an illustration, one way that the soundness of a hypothesis may be presented is to provide a number between, for example, 1 and 10, where 10 indicates maximum soundness (e.g., confidence). Another way to provide an indication of soundness of the hypothesis is to provide a percentage of past reported events that actually supports the hypothesis (e.g., “in the past when you have eaten ice cream, you have gotten a stomach ache within two hours of consuming the ice cream 70 percent of the time”). Of course many other ways of presenting an indication of soundness of the hypothesis may be implemented in various other alternative implementations.

In some implementations, operation 10-736 may include an operation 10-738 for presenting an indication of a temporal or specific time relationship between the at least first event type and the at least second event type as depicted in FIG. 10-7b. For instance, the temporal/specific time relationship presentation module 10-271 of the computing device presenting (e.g., transmitting via a network interface 10-120 or indicating via a user interface 10-122) an indication of a temporal or more specific time relationship between the at least first event type and the at least second event type (e.g., as referenced by the hypothesis). For example, presenting a hypothesis that indicates that a pet dog will go to the backyard (e.g., a first event type) to relieve himself after (e.g., temporal relationship) eating a bowl of ice cream.

In some implementations, operation 10-736 may include an operation 10-739 for presenting an indication of a spatial relationship between the at least first event type and the at least second event type as depicted in FIG. 10-7b. For instance, the spatial relationship presentation module 10-272 of the computing device 10-10 presenting an indication of a spatial relationship between the at least first event type (e.g., boss on vacation) and the at least second event type (e.g., feeling of happiness at work).

Various types of events may be linked together by the hypothesis to be presented through operation 10-736 of FIG. 10-7b. For instance, in some implementations, operation 10-736 may include an operation 10-740 for presenting an indication of a relationship between at least a subjective user state type and at least an objective occurrence type as indicated by the hypothesis as depicted in FIG. 10-7b. For instance, the event types relationship presentation module 10-268 of the computing device 10-10 presenting an indication of a relationship between at least a subjective user state type (e.g., overall feeling of fatigue) and at least an objective occurrence type (e.g., high blood glucose level) as indicated by the hypothesis.

In some implementations, operation 10-736 may include an operation 10-741 for presenting an indication of a relationship between at least a first objective occurrence type and at least a second objective occurrence type as indicated by the hypothesis as depicted in FIG. 10-7b. For instance, the event types relationship presentation module 10-268 of the computing device 10-10 presenting an indication of a relationship between at least a first objective occurrence type (e.g., consumption of white rice) and at least a second objective occurrence type (e.g., high blood glucose level) as indicated by the hypothesis.

In some implementations, operation 10-736 may include an operation 10-742 for presenting an indication of a relationship between at least a subjective observation type and at least an objective occurrence type as indicated by the hypothesis as depicted in FIG. 10-7b. For instance, the event types relationship presentation module 10-268 of the computing device 10-10 presenting an indication of a relationship between at least a subjective observation type (e.g., and at least an objective occurrence type (e.g., high blood glucose level) as indicated by the hypothesis.

Other types of advisories other than the hypothesis itself may also be presented through operation 10-730 of FIGS. 10-7a and 10-7b in various alternative implementations. For example, in some implementations, operation 10-730 may include an operation 10-743 for presenting an advisory relating to a predication of one or more future events based, at least in part, on the hypothesis as depicted in FIG. 10-7c. For instance, the prediction presentation module 10-273 of the computing device presenting an advisory relating to a predication of one or more future events (e.g., “you will have a stomach ache since you ate an ice cream an hour ago”) based, at least in part, on the hypothesis.

In various implementations, operation 10-730 may include an operation 10-744 for presenting a recommendation for a future course of action based, at least in part, on the hypothesis as depicted in FIG. 10-7c. For instance, the recommendation presentation module 10-274 of the computing device 10-10 presenting a recommendation for a future course of action (e.g., “you should take antacid now”) based, at least in part, on the hypothesis.

In some implementations, operation 10-744 may further include an operation 10-745 for presenting a justification for the recommendation as depicted in FIG. 10-7c. For instance, the justification presentation module 10-275 of the computing device 10-10 presenting a justification for the recommendation (e.g., “you just ate at your favorite Mexican restaurant, and each time you have gone there, you ended up with a stomach ache”).

In some implementations, operation 10-730 may include an operation 10-746 for presenting an indication of one or more past events based, at least in part, on the hypothesis as depicted in FIG. 10-7c. For instance, the past events presentation module 10-276 of the computing device 10-10 presenting an indication of one or more past events (e.g., “did you know that the last time you went to your favorite restaurant, you subsequently had a stomach ache?”) based, at least in part, on the hypothesis.

Referring back to the action execution operation 10-606 of FIG. 10-6, in various implementations, the one or more actions to be executed in the action execution operation 10-606 may involve the prompting of one or more devices (e.g., sensing devices 10-35* or devices 10-55) to execute one or more actions. For example, in some implementations, the action execution operation 10-606 may include an operation 10-747 for prompting one or more devices to execute one or more actions as depicted in FIG. 10-7d. For instance, the device prompting module 10-277 of the computing device 10-10 prompting (e.g. as indicated by ref., 25 of FIG. 10-1a) one or more devices (e.g., one or more sensing devices 10-35* or one or more devices 10-55 such as an automobile or a portion thereof, a household appliance or a portion thereof, a computing device, a communication device, and so forth) to execute one or more actions. Note that the word “prompting” does not require the immediate or real time execution of one or more actions. Instead, the one or more actions may be executed by the one or more devices at some later point in time from the point in time in which the one or more devices was directed or instructed to execute the one or more actions.

In some implementations, operation 10-747 may include an operation 10-748 for instructing the one or more devices to execute one or more actions as depicted in FIG. 10-7d. For instance, the device instruction module 10-278 of the computing device 10-10 instructing the one or more devices (e.g., one or more sensing devices 10-35* or one or more devices 10-55 such as an automobile or a portion thereof, a household appliance or a portion thereof, a computing device, a communication device, and so forth) to execute one or more actions. For example, instructing a GPS to provide a current location for a user 10-20*.

In some implementations, operation 10-747 may include an operation 10-749 for activating the one or more devices to execute one or more actions as depicted in FIG. 10-7d. For instance, the device activation module 10-279 of the computing device 10-10 activating the one or more devices (e.g., home air conditioner/heater) to execute one or more actions (e.g., cooling or heating the home).

In some implementations, operation 10-747 may include an operation 10-750 for configuring the one or more devices to execute one or more actions as depicted in FIG. 10-7d. For instance, the device configuration module 10-280 of the computing device 10-10 configuring the one or more devices (e.g., automatic lawn sprinkler system) to execute one or more actions.

In some implementations, operation 10-747 may include an operation 10-751 for prompting one or more environmental devices to execute one or more actions as depicted in FIG. 10-7d. For instance, the device prompting module 10-277 of the computing device 10-10 prompting one or more environmental devices (e.g., air conditioner, heater, humidifier, air purifier, and/or other environmental devices) to execute one or more actions.

In some implementations, operation 10-747 may include an operation 10-752 for prompting one or more household devices to execute one or more actions as depicted in FIG. 10-7d. For instance, the device prompting module 10-277 of the computing device 10-10 prompting one or more household devices (e.g., coffee maker, television, lights, and so forth) to execute one or more actions.

In some implementations, operation 10-747 may include an operation 10-753 for prompting one or more of the sensing devices to execute one or more actions as depicted in FIG. 10-7d. For instance, the device prompting module 10-277 of the computing device 10-10 prompting one or more of the sensing devices 10-35* (e.g., environmental temperature sensor device 10-298) to execute one or more actions.

In some implementations, operation 10-747 may include an operation 10-754 for prompting a second one or more sensing devices to execute one or more actions as depicted in FIG. 10-7d. For instance, the device prompting module 10-277 of the computing device 10-10 prompting a second one or more sensing devices 10-35* (e.g., environmental humidity sensor device 10-299) to execute one or more actions.

In some implementations, operation 10-747 may include an operation 10-755 for prompting the one or more devices including one or more network devices to execute one or more actions as depicted in FIG. 10-7d. For instance, the device prompting module 10-277 of the computing device 10-10 prompting the one or more devices 10-55 including one or more network devices (e.g., when one or more of the devices 10-55 are linked to the wireless and/or wired network 10-40) to execute one or more actions.

What is claimed is:

1.-190. (canceled)

191. A computationally-implemented method, comprising:
selecting, by one or more processors, at least one hypothesis from a plurality of hypotheses relevant to a user, the selection of the at least one hypothesis being based, at least in part, on at least one reported event associated with the user; and
presenting one or more advisories related to the hypothesis.

192. The computationally-implemented method of claim 191, wherein said selecting, by one or more processors, at least one hypothesis from a plurality of hypotheses relevant to a user, the selection of the at least one hypothesis being based, at least in part, on at least one reported event associated with the user comprises:
selecting at least one hypothesis that relates to at least one objective occurrence type.

193. The computationally-implemented method of claim 191, wherein said selecting, by one or more processors, at least one hypothesis from a plurality of hypotheses relevant to a user, the selection of the at least one hypothesis being based, at least in part, on at least one reported event associated with the user comprises:
selecting from the plurality of hypotheses at least one hypothesis that links at least a first event type with at least a second event type.

194. The computationally-implemented method of claim 191, wherein said presenting one or more advisories related to the hypothesis comprises:
indicating the one or more advisories related to the hypothesis via a user interface.

195. The computationally-implemented method of claim 191, wherein said presenting one or more advisories related to the hypothesis comprises:
transmitting the one or more advisories related to the hypothesis via at least one of a wireless network or a wired network.

196. The computationally-implemented method of claim 195, wherein said transmitting the one or more advisories related to the hypothesis via at least one of a wireless network or a wired network comprises:
transmitting the one or more advisories related to the hypothesis to the user.

197. The computationally-implemented method of claim 195, wherein said transmitting the one or more advisories related to the hypothesis via at least one of a wireless network or a wired network comprises:
transmitting the one or more advisories related to the hypothesis to one or more third parties.

198. The computationally-implemented method of claim 191, wherein said presenting one or more advisories related to the hypothesis comprises:
presenting an advisory relating to a predication of a future event.

199. The computationally-implemented method of claim 191, wherein said presenting one or more advisories related to the hypothesis comprises:
presenting a recommendation for a future course of action.

200. A computationally-implemented system in the form of an article of manufacture, comprising:
means for selecting at least one hypothesis from a plurality of hypotheses relevant to a user, the selection of the at least one hypothesis being based, at least in part, on at least one reported event associated with the user; and
means for presenting one or more advisories related to the hypothesis.

201. An article of manufacture, comprising:
a non-transitory storage medium bearing:
one or more instructions for selecting at least one hypothesis from a plurality of hypotheses relevant to a user, the selection of the at least one hypothesis being based, at least in part, on at least one reported event associated with the user; and
presenting one or more advisories related to the hypothesis.
